(19) United States
(12) Patent Application Publication
(10) Pub. No.: US 2002/0091991 A1
(43) Pub. Date: Jul. 11, 2002

(54) Unified real-time microprocessor computer

(76) Inventor: Juan Carlos Castro, Miami, FL (US)

Correspondence Address: Juan Carlos Castro, P.O. Box 557188, Miami, FL, 33255-7188, US

(21) Appl. No.: 09/852,834

(22) Filed: May 10, 2001

Related U.S. Application Data
(60) Provisional application No. 60/203,575, filed on May 11, 2000.

(51) Int. Cl. G06F 9/44

(52) U.S. Cl. 717/106

(57) ABSTRACT

A multiport revolving chambered homing binary hunting metallic track encasing hermetic data link caster dart castings constrained new software parallel redundancy cosmos robotizing unified real-time microprocessor machine language computer whose universal dominion domain outline involves automatizing real-time holistically steady state synchronized ubiquitous continuum sub-loculated cyclical parallel redundancy cosmos robotizing unified real-time microprocessor computer logic instructions of multiport revolving chambered homing binary hunting metallic track encasing hermetic data link caster dart castings constrained new end-user graphical human apostrophe interface syntactic synthesis real-time software programs block; multiport revolving chambered homing binary hunting metallic track encasing hermetic data link caster dart castings constrained new algebraic problem-solving application syntactic synthesis real-time software programs block; multiport revolving chambered homing binary hunting metallic track encasing hermetic data link caster dart castings constrained new robotizing gauge indicating guidance syntactic synthesis real-time software programs block; multiport revolving chambered homing binary hunting metallic track encasing hermetic data link caster dart castings constrained new commerce and transactional exchange methodology syntactic synthesis real-time software programs block; multiport revolving chambered homing binary hunting metallic track encasing hermetic data link caster dart castings constrained new commerce and trade languages combinatorial syntactic synthesis real-time software programs block; a complete real-time microprocessor logic instructing compact integrated originating real-time software generator AND-OR closed-circuitry microprocessor operating system block concretizing rubric identic automatizing real-time holistically steady state synchronized ubiquitous continuum universal executive microprogrammable systematic codified microprocessor machine language logic operator instructions of one-time programmable read-only memory (PROM); a multiport revolving chambered homing binary hunting metallic track encasing hardcore software accumulator controlling central processing unit (CPU).

### CROSS-REFERENCE TO RELATED APPLICATION

This application is entitled to the benefit of Provisional Patent Application titled “Real-Time Capital Market Operating System,” assigned Serial No. 60/203,575, filed on May 11, 2000.

### BACKGROUND

1. Field of Invention

UNIFIED REAL-TIME MICROPROCESSOR COMPUTER is a novel, unobvious, unknown, unforeseen, unprecedented, epoch, paper-less, ease of use, fruitful, opportune, never faltering and never failing panacean cutting-edge breakthrough utility engineering and groundbreaking technological architectural design innovation which is a self-contained, fault-tolerant, anonymous, independent, autonomous, impartial, apolitical, streamlined, alternating scale, and inseparable, proprietary multiport revolving chambered homing binary hunting metallic track encasing hermetic data link caster dart time microprocessor machine language computer block whose universal dominion domain outline is comprehensively suitable, generally pertinent and broadly useful anytime, anyplace and anywhere traversing the sovereign national so-called borders of every and all industrialized, developing and developed free-market commerce and trade bloc economies within, throughout and transcending a holistic single global econometric marketplace environment; wherefrom hereto concretizing via consummate melioristic logical positivism devotional praxis and timely constructive reduction to practice an innovatively conceived real-time processing and/or reprocessing of data and/or information via continuous uptime steady state ubiquitous automatizing instantaneous real-time transmission and transport converter receiver conduit unified real-time microprocessing information technology; wheras, aforementioned information technology which is infinitely and unequivocally comprehensively suitable, generally pertinent and broadly useful to supplant every and all heretofore antiquated, archaic, ancient history and superannuated processes, methods, techniques, capacities, combinations and preconceived notions involving, without limitation, any and/or all of the following: retrieving; converting; formatting; processing; storing; gathering; compiling; tabulating; casting; calculating; preparing; editing; tracing; verifying; submitting; confirming; validating; booking; classifying; categorizing; adjusting; altering; revising; changing; billing; collecting; producing; composing; conducting; proofing; filtering; pressing; publishing; cataloging; indexing; scripting; locating; shooting; running; releasing; posting; compressing; presenting; releasing; playing; displaying; projecting; broadcasting; syndicating; whereas, moreover inclusive of, without limitation, supplanting every and all antiquated, archaic, ancient history and superannuated preconceived notions of the following: reretrieval; retransport; reconversion; reformatting; reprocessing; resaving; restoring; reidentifying; regathering; resorting; reorganizing; recompiling; retabulating; recasting; recalculating; repreparing; reediting; retracing; reverifying; resubmitting; reconfirming; revalidating; rebooking; reclassifying; recategorizing; readjusting; realtering; rerevising; rechanging; recharging; rebilling; recollecting; reproducing; recomposing; reconducting; reproofing; refiltering; repressing; republishing; reprojecting; rebroadcasting; resyndicating; wherefrom, hereto collectively innate conception, terminological conveyance, indivisible rubrical, syntactic oralformulaic, systematic arrangement, artistic construct, melodious lyrics, denominative literateness and thereat proprietary multiport revolving chambered hunting metallic track encasing hermetic new software lock up cast casing constrained real-time microprocessor engineering machine language unicore operating system software computing block keyhole combinational code heretofore and hereafter apprehends UCMOST™ real-time processing and/or reprocessing; proprietary trademark and service mark is exclusive proprietary intellectual property belonging exclusively and unequivocally to Juan Carlos Castro. Wherefrom hereto and hereinafter aforementioned UCMOST™ real-time processing and/or reprocessing automatizing real-time holistically steady state synchronized ubiquitous continuum sub-loculated cyclical parallel redundancy cosmos robotizing unified real-time microprocessor computer logic instructions propagating, promulgating and proclaiming universal dominion isomorphic domain rubricated pragmatic sanction across-the-board traversal of breakthrough technological and groundbreaking innovative developments and advancements in multifaceted and multidimensional microcosmic techniques, designs, systems, routines, devices, manners, modes, fashions, forms, formats, factors, objects, parts, segments, elements, components, constituents, ingredients, processes, methods and combinations; wherefrom moreover hereto entailing, encompassing, comprising, involving, impacting and/or effecting streamlined, alternating scale, inseparable, seamless and natural wrapping, interlacing, coiling, coupling, combining and interlocking every and all of the following: proprietary multiport revolving chambered homing binary hunting metallic track encasing hermetic data link caster dart castings constrained new end-user graphical human apostrophe interface syntactic synthesis real-time software programs block; proprietary multiport revolving chambered homing binary hunting metallic track encasing hermetic data link caster dart castings constrained new algebraic problem-solving application syntactic synthesis real-time software programs block; proprietary multiport revolving chambered horning binary hunting metallic track encasing hermetic data link caster dart castings constrained new robotizing gauge indicating guidance syntactic synthesis real-time commerce and transactional exchange methodology syntactic synthesis real-time software programs block; proprietary multiport revolving chambered homing binary hunting metallic track encasing hermetic data link caster dart castings constrained new commerce and trade languages combinatorial syntactic synthesis real-time software programs block; wherefrom every and all proprietary creative original conceptions, engineering utilities, aesthetic architectural designs, authentic compositions and genuine productions of a sole legal owner; wherefrom herewith concretizing consummate and constructive reduction to practice a complete sub-loculated cyclical parallel redundancy cosmos robotizing real-time microprocessor machine language logic instructing compact integrated new software generator AND-OR closed-circuitry wheresoever transcendent EPROM, degausse and/or magnetostriction preemptively constrained ferromagnetic alloy, silicon, germanium, biodynamic and/or geomagnetic resonant soundproof and fireclay wall protective fireball impervious microcircuit epoxy casting insulated microprocessor engine machine language operating system computing block; wherefrom infinitely automatizing real-time holistically steady state synchronized ubiquitous continuum universal executive sub-compartment cyclical parallel redundancy cosmos robotizing real-time accurate, high-quality, never faulting, fully reliable, never failing, simplified and streamlined microprogrammable systematically codified microprocessor machine language logic instructions entailing, encompassing, comprising, involving, impacting and/or effecting every and all one-time programmable read-only memory (PROM) within a proprietary multiport revolving chambered homing binary hunting metallic track encasing hermetic data link caster dart castings constrained engine block protective contactor composite soundproof housing and fireclay sealed wall casting fireball impervious carriage data link caster dart castings accumulator controlling central processing unit (CPU) concretizing via conducive appendicular microelectronic templates appended, fixed, soldered, mounted, etched, embedded, copied, inscribed and/or contact printed onto every and all heretofore and hereafter mechanical and/or electrical devices, articles, apparatuses and/or megastructure microcircuit processing computing motherboards; wherefrom hereto intrinsic and integral as comprehensively suitable, generally pertinent and broadly useful within every and all automatizing high-quality protective contactor composite housing carriage devices, articles, apparatus, refractories and/or megastructures; wherefrom hereto successfully embroidering unequivocal absolute resolution proprietary revelatory cognizable relativistic relational melioristic logical positivism syntactic synthesis controlling central processing unit (CPU) fixture originating within every and all iota trace element minutia fueling and/or energizing microprocessor semi-conducting chips, whence perpetually propagating, promulgating and proclaiming galactic alternating angle conduit premised on a single alternating scale single independent portal proliferation of artificial semi-conducting microcircuit devices, articles, apparatuses, refractories and/or megastructures; wherefrom propagating traversal of every and all traditonal mechanical friction and/or chemical reaction to fuel power and energy conduit electrical and/or battery generation inclusive of every and all advanced electronic locational systematizing geological and/or seismological processes concretizing innovative wheresoever transcendent EPROMK degauss and/or magnetostriction preemptively constrained ferromagnetic alloy, silicon, germanium, biodynamic and/or geomagnetic resonant soundproof and fireclay wall protective fireball impervious microcircuit epoxy casting insulated permeability of artificial semi-conducting microcircuit devices, articles, apparatuses, refractories and/or megastructures internalizing upright orthorhombic tentacular boundless steady state roving antennule transmuting metric conversional transistor transfusing receiver concretizing high-quality holistically steady state heliocentrically synchronizing ubiquitous hunting continuum parallel redundancy cosmos robotizing digitalized galactic transmitting receiver of spatiotemporal emitted broadcasting of real-time microprocessing traversing a single independent portal refractory evincing minutia partible iota beta particle trace element wave front continuous spectrum pulse signaling transmission conveying efficient energizing and fueling powered catalytic conduits via electrogasdynamics, electrogenesis, electrohydraulic, geomagnetic, gyromagnetic, geokinetic and/or thermodynamic setting transistorized rheostat regulated transfusing partible trace element staple actualizing galactic and/or intergalactic gyroscopic axisymmetrical stabilizing self-impetus protective contactor composite housing carriage hermetic cast lock up software encased unified real-time microprocessor machine language computer block comprehensively innate conception, terminological conveyance, indivisible rubric, syntactic oralformulaic, unique artwork, systematic arrangement, differentiated crafting, artistic construct, melodious lyrics, denominative literateness and thereat proprietary multiport revolving chambered binary hunting metallic track encasing hermetic lock up cast casing constrained unified real-time microprocessor machine language object block keyhole combinational software computer code heretofore and hereafter apprehends UCMOST™.

### COPYRIGHTS NOTICE

Whereas, preemptively apprehending every and all entire, complete and unwavering steadfast protection via International Copyright Code and/or Title 17 of the U.S. Code, hereto several multifaceted and multidimensional panacean cutting-edge technological innovative techniques, designs, systems, routines, devices, manners, modes, fashions, forms, formats, factors, objects, parts, segments, elements, components, constituents, ingredients, processes, methods and combinations entailing, encompassing, comprising, involving, impacting and/or effecting the disclosure of this legal patent document and legal patent disclosure contains multitasking, multifaceted, multidimensional and unequivocally multinational catholicon evidentiary proprietary revelatory syntactic cognizance relativistic melioristic logical positivism relational synthesis epistle epiphany and epistemological epistolary epitaph which is undeniably proprietary and exclusively conceptual art and ornamental design innovations evincing intellectual property congenital, cognitional, conceptualistic, prefiguration, configurational and confidential elements, components, constituents, factors and/or ingredients involving arrangements, structures, organizations, engineering, devises, developments, plans and authorship of literary, melodius, melioristic logical positivism, rubrical and artistic copious works of ideas, conceptions, cognizance, know-how, material, information, issues and concerns inclusive of cautionary caustic caster casing constraining and strategically prefabricated rubric immunizing supernumeric melioristic logical positivism econometric transactional exchange consummate and consecratory practice initiatives, schemes, formulaic, names, likeness, personifications, titles, interests, entitlements, embodiments, embroiderings, submissions, records, activities, actions, events, endeavors, tasks and affairs entailing, encompassing, comprising, involving, impacting and effecting all conceptually authentic compositions and abstract genuine productions owned exclusively via a freeborn, freestanding and freethinking sole legal owner of life, copyrights and intellectual property assize © 1999-2001 Juan Carlos Castro. Whereas, irrespective of whether or not herewith deemed patentable as utilities and designs or otherwise applicable wherefrom unremittingly, unequivocally, rightfully and justifiably entitled to every and all protections and/or offensive rights under the law wherefrom hereto subject to every and all forms of copyright protection evincing a legal means of preventing the illegal or unauthorized coyring of a printed text, graphic design image, literary, melodius and artistic authorship of manuscripts, software programs, software processes, words to be printed and/or spoken, commerce trademark, commerce service mark, source material applicable to authorship and/or artistry material wherefrom hereto such copyright protection as an undeniable and evindentiary findings of fact, documented reference, logical scientific deduction and intuitive analytical reasoning evinces the sole legal right to exclusive publication, production, sale and distribution of every and all products, goods, services and supplies hereto belongs clearly, undeniably, evidently, logically, scientifically and intuitively to rubric assize © 1999-2001 Juan Carlos Castro, wherefrom heretofore and hereafter apprehending UCMOST™; whereas, real-time information technology trademark and service mark is exclusive proprietary intellectual property belonging exclusively and unequivocally assize © 1999-2001 Juan Carlos Castro. Whereas, hereto above and below specified aforementioned UCMOST™ real-time processing and/or reprocessing involves propagating, promulgating and proclaiming universal dominion isomorphic domain identic syntactic rubricated pragmatic sanction which is undeniably infinitely and unequivocally comprehensively suitable, generally pertinent and broadly useful wherever entailing, encompassing, comprising, involving, impacting and/or effecting proprietary multiport revolving chambered hunting metallic track encasing hermetic new software lock up cast casing constrained real-time microprocessor engineering machine language unicore operating system software computing block keyhole combinational code; wheres, inclusive of every and all limited organizations embroidering multifaceted and multidimensional copious works of a freeborn, freestanding and freethinking sole legal owner of life, copyrights and intellectual property; whereas, whether potentially patentable as novel utility and/or whether potentially patentable as aesthetic ornamental design exclusively proprietary and belonging to a freeborn, freestanding and freethinking sole legal owner of life, copyrights and intellectual property assize © 1999-2001 Juan Carlos Castro. Whereas, unless otherwise referenced to another sourced literary publications every and all, without limitation, literary, engineering and design multitasking, multifaceted, multidimensional and unequivocally multinational catholicon evidentiary proprietary revelatory syntactic cognizance relativistic melioristic logical positivism relational synthesis epistle epiphany and epistemological epistolary epitaph is proprietary and exclusively intellectual property proprietary belonging unequivocally to a freeborn, freestanding and freethinking sole legal owner of life, copyrights and intellectual property whom through life and intellectual thought conceptual processes, capacity, methodology and combinations innately traverses the national sovereign so-called borders of every and all industrialized, developed and developing free-market commerce and trade bloc economies within, throughout and transcending a holistic single global econometric marketplace environment via every and all proprietary intellectual property techniques, designs, systems, routines, devices, manners, modes, fashions, forms, formats, factors, objects, parts, segments, elements, components, constituents, ingredients, processes, methods and combinations hereinbefore and hereinafter fully disclosed without hesitation, obstruction, obfuscation, holding, restraining and/or delay wherefrom evincing specifications and embodiments manuscripted material documentation and literary, melodius and artistic composition unequivocally and legally deducing authenticated know-how, copious works of art, literary authorship and aesthetic article ornamental utility and design compositions belonging exclusively to a freeborn, freestanding and freethinking sole legal owner of life, copyrights and intellectual property assize © 1999-2001 Juan Carlos Castro. Whereas, cogitate although the sole legal owner of copyrights displays no explicit objection to a facsimile reproduction of the proof of this invention a literary, melioristic logical positivism, melodius and aesthetic artistic ornamentational utlity and design strictly, restrictively and exclusively as it appears in Patent and Trademark Office(s) patent files and records traversing every and all of the national sovereign so-called borders of industrialized, developed an developing free-market commerce and trade bloc economies anyplace, anywhere and anytime filed and/or prospectively potentially filed anywhere, anyplace and anytime astir cautionary caustic caster rubricated casing embroidering a universe hereto attributively ascribing a freeborn, freestanding and freethinking sole legal owner of life, copyrights and intellectual property hereto apt artificer wherefore aforementioned notwithstanding, wherefrom hereto and herewith is established clear, concise and evident reference, posting and display assize “puts on notice” every and all knowing, unknowing, cognizant, incognizant inclusive of, without limitation, every and all heretofore evidentiary inabsentia third party persons, third party legal entities, third party associations and/or third party organizations; wherefrom evincing exclusively hereafter interested and/or heretofore and hereafter uninterested third parties accessing this binding legal patent document and binding legal patent disclosure that no one whichever, whomsoever and whensoever has any rights, titles, interests and/or entitlements to the specifications and/or claims hereto publicly disclosed, and further whereas whichsoever and/or whatsoever third person and/or third party anywhere, anyplace and anytime whom propagates attempting and/or effectuates attempting to restrict, constrain, oppress, repress, obstruct, decieve, conspire, preclude, prevent, seclude, harass, defame, devalue, breach, threatened breach and infringe the proprietary copyrights and/or intellectual property which is comprehensively suitable, generally pertinent and broadly useful to the lifetime melioristic logical positivism lifework importance and belonging exclusively to a freeborn, freestanding and freethinking sole legal owner of life, copyrights and intellectual property assize © 1999-2001 Juan Carlos Castro, will be prosecuted to the extent of national, international and/or transnational laws. Whereas, every and all such strive, sequestration and prosecution shall apply irrespective of the conduit medium of concretizing, actualizing, materializing and/or traversing wherether manually, artistically, theatrically, literarily, melodiously and/or gramatically hereto evincing breach, threatened breach and/or infringement whether knowingly and/or otherwise incognizant orginating anywhere, anyplace and battery, radio, television, telephony, telegraphy, typography, photographic and/or solar conduit involving, without limitation, read and write and/or write-only artifical atmospheric ground wave and/or aeronautical airway casing dish, transmitter, receiver, cassettee, cartridge, pan and/or container inclusive of, without limitation, all the following; microdisk; microfilm; microfiche; microplate; magnetic film; magnetic reel; hard diskette; floppy diskette; magnetic tape drive; magnetic film diskette; magnetic microfilm disk; magnetic microplate disk; paper tape cast; file folder; file drawer; file cabinet; display calculator; cash register; display cash register; display computing article; file storage computing article; teletype interface computing article; teleprompt interface computing article; articled hard core computing disk drive; articled mainframe computing disk drive; articled server computing disk drive; articled network transport routing computing disk drive; articled magnetic reel computing disk drive; articled personal hard computing disk drive; articled desktop hard computing disk drive; articled personal laptop computing disk drive; articled personal tablet computing disk drive; articled personal telephony computing disk drive; articled video game computing disk; articled digital video computing disk will be sequestered and prosecuted thoroughly to ceast-and-desist court orders. Whereas, via this single reference the entirety of this legal patent document and legal patent disclosure below evincing constructive reduction to melioristic logical positivism practice of art involves transnatinal transactional exchange initiatives, schemes, formulaic, names, likeness, personifications, titles, interests, entitlements, embodiments, embroiderings, objects, devises, plans, claims, ocurrences, happenings, interactions, processes, methodology, movements, proceedings, messaging, presentations, notifications, filings, submissions, records, activities, actions, events, endeavors, tasks and affairs entailing, encompassing, comprising, involving, impacting and effecting all present hereto conceptually authentic compositions and/or abstract genuine productions owned exclusively by a freeborn, freestanding and freethinking sole legal owner of life, copyrights and intellectual property assize © 1999-2001 Juan Carlos Castro. Whereas, this single precautionary and preemptively copyrights owned citing “puts on notice,” every and all unearned, undeniable, unnecessary, unwarranted, illogical, unjustifiable, unrestricted, and furthermore sole owner of copyrights without preemptively and precautionary signing of legal and written non-disclosure, non-circumvention, non-competition and confidentiality contract agreements created by a freeborn, freestanding and freethinking sole legal owner of life, copyrights and intellectual property assize © 1999-2001 Juan Carlos Castro. Whereas, any such legal contracts are to be reviewed, initialed, signed, executed, sealed and delivered with full assent and full consent by the sole legal owner of copyrights and any and all copy material requests are premised exclusively on front-money compenstaory transactional exchanging initiatives, schemes, ocurrences, happenings, interactions, processes, methods, practices, movements, proceedings, messaging, presentations, notifications, filings, submissions, records, activities, actions, events, endeavors, tasks and affairs and wherefrom without prior, precautionary and preemptive legal and written signed, sealed and delivered non-disclosure, non-circumvention, non-competition and confidentiality contract agreements, the sole legal owner of copyrights unexceptionally and unequivocally hereby excludes, precludes, restricts and constrains every and all noncommital nonconformists of the wishes of the exclusive owner of copyrights, intellectual property and this fully disclosued legal patent document, cogitate carefully, assize © 1999-2001 Juan Carlos Castro. Whereas, the sole legal owner of copyrights and intellectual property from mere reivew of this legal patent document and legal patent disclosure as it appears in Patent and Trademark Office(s) patent files and records of every and all of the national sovereign borders of every and all of the industrialized, developed an developing free-market commerce and trade bloc economies wherein filed or prospectively potentially filed anywhere, anyway, anytime and anyplace astir in the universe has no preemptive objection thereto, but otherwise retains all legal rights and enforces all such breach, threatened breach and/or infringement to the full extent afforded under law assize © 1999-2001 Juan Carlos Castro. Whereas, whether potentially patentable statutory, novel and unobvious panacean cutting-edge utility technological engineering and/or aesthetic ornamental architectural design innovations all hereto is exclusively proprietary and belonging unequivocally to a freeborn, freestanding and freethinking sole legal owner of life, copyrights and intellectual property involving the lifetime, lifeline and lifework of legal right of the sole owner of copyrights inclusive of background description of prior art references, background description of objects and advantages, summary of this invention, brief description of graphical illustration of drawings of this invention, list of reference numeral object code of this invention, operation of this invention, description of this invention, conclusion, ramifications and scope, abstract, claims inclusive of every and all art drawings of this legal patent document and legal patent disclosure wherefrom strictly, restrictively and exclusively as it appears in Patent and Trademark Office(s) patent files and records wherefrom hereto anyone and/or anything which, without limitation, directly and/or indirectly, unknowingly copies, unknowingly threatens to copy, knowingly copies, knowingly threatens to copy and/or unknowingly breachs, unknowingly threatens to breach, knowingly breachs, knowingly threatens to breach, inclusive of unknowingly infringes, unknowingly threatens to infringe, knowingly infringes, knowingly threatens to infringe and/or unknowingly reengineers, unknowingly threatens to reengineer, knowingly reengineers, and knowingly threatens to reengineer separately and/or collectively anything even remotely related to innate conception, terminological conveyance, indivisible rubric, syntactic oralformulaic, unique artwork, systematic arrangement, differentiated crafting, artistic construct, melodious lyrics, denominative literateness and thereat proprietary multiport revolving chambered binary hunting metallic track encasing hermetic new software lock up cast casing constrained unified real-time microprocessor machine language computer block keyhole combinational code belonging exclusively to the owner of copyrights assize © 1999-2001 Juan Carlos Castro. Whereas, this preemptive and precautionary “puts on notice,” apprehends all protective copyrights as per International Copyright Laws and/or Title 17 of the U.S. Code, inclusive of every and all potential offensive rights which may instrincally hereto be affixed onto this legal patent disclosure if deemed patentable subsequent to legal public disclosure, wherefrom cogitate thoroughly as it is an undeniable and evidentiary findings of fact, documented reference, logical scientific deduction and intuitive analytical reasoning that every and all, subpeaona and/or inductive prohibtion, sequestration and/or cease-and-desist will be sought in full-scale concert with assistance from every and all legal, polity, enterprise and/or jurisidictional venues and/or courts of law and will be thoroughly, swiftly, legal owner assize © 1999-2001 Juan Carlos Castro. Whereas, this precautionary and preemptive “puts on notice” is comprehensive, clear, evident and concise whereby serving every and all aim, letter, nature, spirit, scope, breadth and depth of law, without limitation, which is comprehensively suitable, generally pertinent and broadly useful to the legal owner of copyrights premised on the findings of fact, every and all hereto are originally, independently and authentically conceived, intellectualized, initiated, undertaken, structured, composed, produced, cited, produced, conducted and directed catalystic conduit propagations and promulgations via literary, melioristic logical positivism, melodious and artistic authored novel ideas, concepts, designs, devises, formulae, plans and claims are exclusive intellectual property rights, titles, interests, entitlement and embodiments of a freeborn, freestanding and freethinking sole legal owner of life, copyrights and intellectual property hereto, and further unequivocally derived exclusively from sole proprietary philosophy, intellectualism, cognizance, time, energy and literary, melioristic logical positivism, melodius and artistic authorship devises, processes, designs inclusive of, without limitation, every and all strategically competitive business trademark, service mark, software code, software titles, software programs, software inclusive of operating system development plans owned exclusively by sole legal owner of copyrights, Juan Carlos Castro, whom hereto is solely deserving, without limitation, of every and all legal rights of software authorship, software titles, software utilities, software engineering, software designs, software programs, software processes, proprietary commercial conceptions, designs, endeavors, plans, devises, merits, credits, honors, graces and earned due perpetual legal intellectual property rights, titles, interests, entitlements to every and all strategically competitive business plans inclusive of every and all hereto logical specificiation, preferred embodiments, alternative embodiments inclusive of additional embodiments inclusive of claim(s) of a freeborn, freestanding and freethinking sole legal owner of life, copyrights and intellectual property assize © 1999-2001 Juan Carlos Castro. Whereas, whomsoever, whichever and/or whensoever via mere review of this legal patent document and legal patent disclosure via Patent and Trademark Office(s), cogitate and beware a freeborn, freestanding and freethinking sole legal owner of life, copyrights and intellectual property hereto entailing, melioristic logical positivism, melodious and artistic information, material, works of art, documentation, ideas, formulaic inclusive of every and all rights of authorship, titles, utilities, designs, software programs, software processes, proprietary strategic competitive conceptions, designs, endeavors, plans, devises, merits, credits, honors, graces and earned due perpetual legal intellectual property rights, titles, interests, entitlements to every and all strategically competitive plans inclusive of legal claims to preferred embodiments, alternative embodiments inclusive of additional embodiments epitomizes eponym upholds cognitive science a lifetime specialization wherefrom hereto preemptively filing this preemptively, precautionary and preceding copyrights notice and filing a legal patent document and legal patent disclosure as a legal capacity to secure all proprietary and exclusively evidentiary copyrights and intellectual property, inclusive of, without limitation, potential patentable claims hereto concretizing via congenital, cognitional, conceptualistic, configurational and confidential arrangements, structures, organizations, engineerings, designs, developments and authorships of literary, melodius, melioristic logical positivism, rubrical and artistic copious works of ideas, conceptions, cognizance, know-how, material, information, concerns inclusive of, without limitation, strategically competitive transactional exchanging initiatives, schemes, ocurrences, happenings, interactions, processes, methods, practices, movements, proceedings, messaging, presentations, notifications, filings, submissions, records, activities, actions, events, endeavors, tasks, affairs, fomulaic, names, likeness, titles, interests, entitlements, embodiments, objects, devises, authentic compositions and/or genuine productions assize © 1999-2001 Juan Carlos Castro. Whereas, heretofore and hereafter due exclusively to the undeniable and evidentiary findings of fact, documented reference, logical scientific deduction and intutive anlytical reasoning that a freeborn, freestanding and freethinking sole legal owner of life, copyrights and intellectual property hereto, heretofore patiently endured self-inspired solitariness in spite of long-term consequential indigence, direst impoverishment, dirt-poor livelihood, emotional suffering, unrestrained tarnation and judgmental crucifixion at the hands of and/or as a function of harming; skirmishing; damaging; inuring; insistent; insinuating; imposing; pestilent; impetuous; importune; pestiferous; condescending; insolent; enthralling; pretending; maleficience; harassing; unmanly, ungodly, condescending, insolent, crucifying, bombarding, boisterous, bolstering, presumptuous, portentous, pretentious, unfruitful, unmerciful, voracious, raptorial and unearthly arctic frigidness, ungracious voraciousness and unfair ruthless behaviors, matters, issues, events, occurrences, transpiring, happening, happenstance and movements evinced from every and all such heretofore bumptious and/or consequential third party interests of known and/or unknown, direct and/or indirect, interaction, association and/or organizational membership. Whereas, heretofore and hereafter no such potentially consequential sociobiological, sociocultural, socioeconomic, sociopolitical, sociopsychological and/or socioreligious, wherefrom esssentially sociodemographics, life attributes and/or cosmetic characteristics association belonging unequivocally to a freeborn, freestanding and freethinking sole legal owner of life, copyrights and intellectual property hereto have any right and/or merit to stipulations and/or propagations against the rights, titles, interests, entitlements, embodiments and claims hereto belonging exclusively to a freeborn, freestanding and freethinking sole legal owner of life, copyrights and intellectual property hereto inclusive of, without limitation, every and all heretofore undeniably, referenced, logically and scientifically evidentiary inabsentia involving every and all, holding and/or fixtured, of the following: so-called grandparentage; so-called parentage; so-called godparent; so-called uncles; so-called aunts; so-called sibling; so-called cousin; so-called friend; so-called teacher; so-called professor; so-called mentor; so-called sage; so-called non-existent partner; so-called non-existent marriage spouse; and so-called non-existent colleagues; so-called marriage spouses; so-called children; so-called heirs; so-called heritors; so-called heirdom; so-called heiress; so-called heir loom; so-called heirship; so-called generic kindred; so-called partners; so-called allys; so-called colleagues; so-called alliances; so-called successors; so-called assigns; so-called persons; so-called proprietor; so-called partnership; so-called company; so-called firm; so-called corporation; so-called incorporation; so-called commercial enterprise; so-called franchise; so called union; so-called thrift; so-called group; so-called board; so-called institute; so-called convention; so-called bicameral; so-called society; so-called chamber; so-called not-for-profit; so-called foundation; so-called endowment; so-called association; so-called so-called town; so-called locale; so-called city; so-called municipal; so-called metropolis; so-called county; so-called district; so-called province; so-called state; so-called federal; so-called country; so-called nation; so-called transnational; so-called multinational; so-called federation; so-called confederation. Whereas, a freeborn, freestanding and freethinking sole legal owner of life, copyrights and intellectual property hereto recongizes and is completely aware of every and all, without limitation, undeniable and evidentiary findings of fact, documented reference, logical scientific deduction and intutive anlytical reasoning that a freeborn, freestanding and freethinking sole legal owner of life, copyrights and intellectual property hereto, heretofore patiently endured utmost solitude and solace, consequential indigence, direst impoverishment, dirt-poor livelihood, emotional suffering, unrestrained tarnation and judgmental crucifixion at the hands of and/or as a function of every and all, without limitation, above referenced abstract specified legal notations and/or below referenced abstract specified legal notations of a freeborn, freestanding and freethinking sole legal owner of life, copyrights and intellectual property assize © 1999-2001 Juan Carlos Castro. Whereas, via this comprehensive, detailed, cautionary and preemptive “puts on notice” offers the only necessary clear, concise and evinced notification and/or messaging to every and all, without limitation, wherefrom beware a freeborn, freestanding and freethinking sole legal owner of life, copyrights and intellectual property hereto is continuously awake and connizant, perpetually marked by resilience, passionately steady state driven, characterized by steadfast perseverance, unashamedly exploits and profits from eevery and all intellectual property belonging exclusively to a sole legal owner, and therefore reciprocates to every and all, without prejudice, selection and/or discrimination, every and all, without limitation, utmost solitude and solace whereupon every and all third party is subjugated to hereafter patiently enduring consequential indigence, direst impoverishment, dirt-poor livelihood, emotional suffering, unrestrained tarnation and judgmental crucifixion at the hands of and/or as a function of: harming; damaging; inuring; insistent; insinuating; imposing; pestilent; impetuous; importune; pestiferous; condescending; insolent; enthralling; pretending; maleficience; harassing; engulfing; pressing; malevolent; presuming; imprinting; malicious; pestering; and Whereas, aforementioned UCMOST™ information technology is an authentic prefiguration and genuine preferential individual conception, solacing construct, and thereat proprietary trademark and/or service mark exclusively legally owned intellectual property of a sole legal owner assize © 1999-2001 Juan Carlos Castro. Whereas, heretofore, hereinafter and hereafter PUBLIC FINANCIALS CORPORATION™ is exclusively a heretofore State of Florida registered for-profit closed-company business enterprise founded solely and incorporated solely by Juan Carlos Castro, Chairman of the Board and Chief Executive Officer, whose formally utilized proprietary tradename and/or service mark is exclusively third party licensed intellectual property belonging to PUBLIC FINANCIALS™, LLC; wherefrom furthermore, PUBLIC FINANCIALS™, LLC is exclusively a heretofore State of Florida registered for-profit limited liability company business enterprise founded solely and organized solely a sole legal owner, Juan Carlos Castro, Managing-Member, whose formally registered and publicized proprietary fictitious tradename and/or service mark PUBLIC FINANCIALS™ is exclusively second-hand licensed intellectual property belonging exclusively to a sole independent inventor and sole legal owner assize © 1999-2001 Juan Carlos Castro. Whereas, heretofore and hereinafter UCMOST™; PUBLIC FINANCIALS CORPORATION™; inclusive of, without limitation, PUBLIC FINANCIALS™; wherefrom are formally utilized and hereinabove and/or hereinbelow disclosed proprietary trademarks, tradenames and/or service marks which are comprehensively suitable, generally pertinent and broadly useful to all world-class exploiting and profiteering strategic transactional exchange initiatives, schemes, ocurrences, happenings, interactions, processes, methods, practices, movements, proceedings, messaging, presentations, notifications, filings, submissions, records, activities, actions, events, endeavors, tasks, affairs, fomulaic, names, likeness, titles, interests, entitlements, embodiments, objects, devises, plans and claims involving innate conception, terminological conveyance, indivisible rubric, syntactic oralformulaic, unique artwork, systematic arrangement, differentiated crafting, artistic construct, melodious lyrics, denominative literateness and thereat proprietary multiport revolving chambered binary hunting metallic track encasing hermetic lock up cast casing constrained unified real-time code belonging exclusively to a freeborn, freestanding and freethinking sole legal owner of life, copyrights and intellectual property belonging exclusively to a sole independent inventor and sole legal owner assize © 1999-2001 Juan Carlos Castro. Whereas, every and all heretofore ascertained and hereinabove and hereinafter fully disclosed to the public via a legal patent document, evinces precedential preparedness, premeditation, prescription and prenuptial congenital, cognitional, conceptualistic, configurational and confidential element systematic arrangements, structures, organizations, engineerings, designs, developments and authorships and artistic copious works of ideas, ideologies, conceptions, cognizance, know-how, material, information, issues and concerns entailing, encompassing, comprising, involving, impacting and effecting every and all strategically exploiting and legally profiteering transactional exchange initiatives, schemes, ocurrences, happenings, interactions, processes, methods, practices, movements, proceedings, messaging, presentations, notifications, filings, submissions, records, activities, actions, events, endeavors, tasks, affairs, fomulaic, names, likeness, titles, interests, entitlements, embroiderings, devices, embodiments, objects, devises, plans and claims assize © 1999-2001 Juan Carlos Castro. Whereas, unreproachably and unequivocally every and all, without limitation, strategically prefabricated world-class exploiting and perpetually profiteering transactional exchanging entailign, encompassing, comprising, involving, impacting and effecting necesssary, prudent, truthful, opportune, fair, just, sound, legal, trustworthy, suitable, pertinent, useful, immunized, immeasurable, nonassessable and holistic rubricating casting a novel competitive panacean, invaluable life, copious copyrights and intellectual property belonging exclusively to a independent creator; whereas, a independent, just, gracious, honorable, thoughtful, benevolent, compassionate and sole legal owner, cogitate assize © 1999-2001 Juan Carlos Castro.

2. Prior-Art References

Although a limited few related prior-art references do describe and explain various systems and procedures for the collection, assembly, processing, storage, and distribution of instrument transactional exchange data whereas, it is clearly an undeniable and evidentiary reasoning that above and below referenced UCMOST information technology is a foundational resolution to every and all of the heretofore unaddressed and unresolved tremendously long-held and enormously heart-felt unmet needs in the relevant art. Whereas, aforementioned UCMOST™ information technology unequivocally and undeniably offers a novel, unobvious, unknown, unforeseen, epoch and unprecedent innovative technological resolution which supplants every and all of the heretofore unaddressed and unresolved tremendously long-held and enormously heart-felt unmet needs in the relevant art which have risen as a consequence of the proliferation of inefficient, ineffective, dysfunctional and fragmented telecommunications techniques, methods, capcities, processes, procedures, combinations and protocols inclusive of, without limitation, the undeniable and evidentiary inefficient, portentous, menacing, presumptuous and fruitless so-called wire jack line and/or wireless so-called Internet/World Wide Web methodologies, technologies, capacities, procedures, combinations and/or protocols of accessing, gathering, and transporting via every and all antiquated, archaic, ancient history and superannuated methodological pooling and/or batch transmission of data and/or information to/from receivers to communicate across short and long-distances alike via time-lagged, hesitant, holding, delayed, imprudent, detrimental and debilitating methodologies via antiquated, archaic, ancient history and superannuated methodologies of identifying, organizing, cataloging, indexing, categorizing, processing and thereupon deriving every and all collections of featured, displayed, projected and/or presented literary, theatrical, melodious and/or aesthetic works involving every and all presumptuous, portentous, pretentious, pernicious, antiquated, archaic, ancient history and superannuated disparate and/or compressible digitalized artistic, theatrical, logic, heurisitc, inference, charactery, numeric, literary, melodius, auditory and video data transport control processing format protocols broadcasting, distributing and/or syndicating transmission and/or rebroadcasting, redistributing and/or resyndicating time-lagged spooling and/or batch processing transmission to/from converting receiver inclusive of, without limitation, every and all so-called apostrophe applications inclusive of all the following: whereas so-called windows operating system (WINDOWS) computing graphical software programs; whereas, so-called beginner's all-purpose symbolic instruction code (BASIC) called windows (Media Player) streaming applications computing software programs; whereas, so-called extensible mark-up (XML) seamless linkage interconnect software computing programs; whereas, so-called standard operating applications programs (SOAP) seamless linkage interconnect software computing systems; whereas, so-called dewey decimal system (DEWEY) disparate and/or integrated charactery and numismatic format processing software computing programs; whereas, so-called Movie Pictures Experts Group (MPEG-4) streaming applications computing software programs; whereas, so-called (MP3) streaming digitalized auditory applications computing software programs; whereas, so-called (Plug-and-Play) wire jack line and/or wireless modem driven streaming applications computing software programs; so-called (Real Player) streaming applications computing software programs; whereas, so-called unisys (UUNET) disparate charactery and numismatic format processing software computing programs; whereas, so-called unisys (UNIX) disparate charactery and numismatic format processing software computing programs; whereas, so-called obscured and/or opaquely situated (META) disparate charactery and numismatic format processing software computing programs; whereas, so-called common business oriented languages (COBOL); so-called common microcomputing languages (C; C+; C++); whereas, so-called high level programming algebraic problem-solving languages (FORTRAN); whereas, so-called linux open-source (LINUX) computing software programs; whereas, so-called programming in logic (PROLOG) computing software programs; whereas, so-called toddler, children and/or adolescent educational programming (LOGO) computing software application programs; whereas, so-called defense emergency final contact operating network (DEFCON) computing systems and/or computing software programs; whereas, so-called global positioning system (GPS) computing software programs; whereas, so-called oracle financial application (ORACLE) computing software programs; whereas, so-called linux open-source (LINUX) computing operating systems; so-called superannuated basic input/output systems (BIOS) microcomputing language applications software programs; whereas, so-called interfacing open source foundational java (JAVA) streaming computing software programs; whereas, so-called human apostrophe peer-to-peer and business-to-business so-called open source foundational jxta (JXTA) streaming computing software (ISBN) disparate and/or integrated charactery and numismatic format processing software computing programs; whereas, so-called electronic data processing (EDP) disparate and/or integrated charactery and numismatic format processing software computing programs; whereas, so-called just-in-time (JIT) inventory management tracking software computing programs routing and updating methodologies; whereas, so-called activity-based-cost (ABC) inventory management charactery and/or numeric spreadsheet driven software computing programs; so-called ethernet and/or local area network network management switching software processing computing programs; whereas, so-called portfolio asset class allocation (EnCORR) selection and analysis software computing programs; so-called portfolio asset class allocation (EnCORR) optimizing and efficient frontier analyticalsoftware computing programs; so-called electronic money, banking and/or tax preparation and collection (QUICKEN) processing software computing programs, whereas, so-called Transmission Control Protocol/Internetworking Protocol (TCP/IP) internetwork telecommunications accessible software computing programs interfacing methodologies; whereas, so-called Internet file transport protocol (FTP) software computing methodologies; whereas, so-called Internet go for (GOPHER) software computing methodologies; whereas, so-called Internet hyper-text transport protocol (HTTP) widely recognized and speciuosly registered .com, .net., .org., .edu, .gov, and .cc interaccessible software computing programs interfacing methodologies; whereas, so-called extracellular and/or extracorporeal wireline and wireless multiplexed apostrophe electrograph, electrostatic, electrothermal, photographic, xerographic, thermographic, thermostatic, thermoelectric, telecast, teletext, teletype, televise, telefacsimile, telegraphy, telemetry, telephony, frame-relay wireline; fixtured wireline, sporadic wire, cable, fiber, film, optic, glass, infrared, radio, television, projection, cinema, radar and/or artificial satellite network storage and/or routing software processing computing programs; whereas, so-called domain name suffix ending labeled universal reference languages (URL) access locational and reference directional interaccessaible software computing programs interfacing methodologies; whereas, so-called world wide web (WWW) internetwork data routing interaccessible software computing programs interfacing methodologies; whereas, so-called hyper-text messaging language (HTML) page network management switching; whereas, so-called bluetooth (BLUETOOTH) interoperable computing software programs; whereas, so-called Peripheral Component Interconnect (PCI) interoperable serial busing applications software computing programs; whereas, so-called 802.11 (IEEE) wireless local area (WAN) and/or local area network (LAN) streaming applications computing software programs; whereas, so-called 802.11b (IEEE) wireless high-frequency streaming applications computing software programs; whereas, so-called macintoch (QuickTime) streaming applications computing software programs; whereas, so-called macintoch (MAC) computing operating system graphical software programs; whereas, so-called macintoch disk operating system (MAC) computing graphical software programs; wherefrom evincing every and all antiquated, archaic, ancient history and superannuated methodological pooling and/or batch transmission software programs transport control processing format protocols. Wherefrom, moreover whichever, whereever and whensoever every and all above aforementioned have risen exponentially and predominately needlessly from rapid escalation of depositors and/or member-subscribers accessing antiquated, archaic, ancient history and superannuated processing and/or reprocessing of data and/or information receiver of financial and non-financial instrument transactions from multitudes of disparate, presumptuous, portentous, pretentious, fruitless, antiquated, archaic, ancient history and superannuated physical, electronic, telephony, virtual, dumb terminal and/or so-called webpages and/or web-sites within, throughout and transcending the national sovereign so-called borders of a single holistically econometric marketplace environment, which heretofore further evinces every and all entailing, encompassing, comprising, involving, impacting and/or effecting various multidimensional boisterous, pretentious, portentous and pretentious proliferation of the disparate utilization of obscurant, irresponsible, feculent, irrational, feckless, disrespectful, mendacious, ignorant, malicious, condescending, untruthful, insolent, inefficient, incognizant, ineffective, fragmenting, unlettered, unpolished, presumptuous, portentous, pretentious, fruitless, antiquated, archaic, ancient history and superannuated software programs, hardcore computing operating systems, telecommunications and/or telemetry routing and switching infrastructure, personal and/or scalable enterprise network software computing devices, inclusive of, without limitation, every and all hardware computing suitable, generally pertient and broadly useful to whichever, whereever and whenever; and whence, wherefrom evincing every and all feculent, feckless, inefficient, portentous, fruitless, antiquated, archaic, ancient history and superannuated real-time processing and/or reprocessing of data and/or information receiver of every and all, without limitation, inclusive of: feculent, feckless, ineffective, presumptuous, fragmented, antiquated, archaic, ancient history and superannuated dot matrix printing instrument processing; feculent, feckless, ineffective, presumptuous, fragmented, antiquated, archaic, ancient history and superannuated daizy wheel printing instrument processing; antiquated, archaic and ancient hisotry ink jet; feculent, feckless, ineffective, presumptuous, fragmented, antiquated, archaic, ancient history and superannuated laser printing instrument processing; wireless portable personal digital assistants instrument processing; wireless portable personal tablet laptop instrument processing; wireless portable wide area network combined with local area network routing and switcing management access manual and/or automatizing telephone instrument processing; portable standalone and portable fixtured manual pre-pay and/or automated pre-paid calling card telephone instrument processing; fixtured standalone and carrier fixtured manual pre-pay and/or automated pre-paid calling card telephone instrument processing; portable standalone and portable fixtured automatizing keystroke board instrument processing; fixtured standalone and carrier fixtured automatizing keystroke board instrument processing; portable standalone and portable fixtured automatizing keystroke pad instrument processing; fixtured standalone and carrier fixtured automatizing keystroke pad instrument processing; portable standalone and portable fixtured automatizing touchstroke board instrument processing; fixtured standalone and carrier fixtured automatizing touchstroke board instrument processing; portable standalone and portable fixtured automatizing touchstroke pad instrument processing; fixtured standalone and carrier fixtured automatizing touchstroke pad instrument processing; portable standalone and portable fixtured automatizing auditory-stroke board instrument processing; fixtured standalone and carrier fixtured automatizing auditory-stroke board instrument processing; portable standalone and portable fixtured automatizing auditory-stroke pad instrument processing; fixtured standalone and carrier fixtured automatizing auditory-stroke pad instrument processing; portable standalone and instrument processing; portable standalone and portable fixtured automatizing remote activated radar-stroke pad instrument processing; fixtured standalone and carrier fixtured automatizing remote activated radar-stroke pad instrument processing; portable standalone and portable fixtured automatizing remote activated airliner warning and control system traffic instrument processing; fixtured standalone and carrier fixtured automatizing remote activated airliner warning and control system traffic instrument processing; portable standalone and portable fixtured automatizing remote activated airborne warning and control system surveillance instrument processing; fixtured standalone and carrier fixtured automatizing remote activated airborne warning and control system surveillance instrument processing; portable standalone and portable fixtured automatizing remote activated airborne electronic grounding information system surveillance instrument processing; fixtured standalone and carrier fixtured automatizing remote activated airborne electronic grounding information system surveillance instrument processing; further inclusive of without limitation: portable standalone and portable fixtured automatizing telephone instrument processing; fixtured standalone and carrier fixtured automatizing telephone instrument processing; portable standalone and portable fixtured automatizing public access call box telephone instrument processing; fixtured standalone and carrier fixtured automatizing public access call box telephone instrument processing; portable standalone and portable fixtured automatizing facsimile instrument processing; fixtured standalone and carrier fixtured automatizing facsimile instrument processing; portable standalone and portable fixtured automatizing vending instrument processing; fixtured standalone and carrier fixtured automatizing vending instrument processing; portable standalone and portable fixtured spatiotemporal automated teller instrument processing; fixtured standalone and carrier fixtured spatiotemporal automated teller instrument processing; portable standalone and portable fixtured spationtemporal manual and/or automatizing gasoline service station fueling, upkeep and/or repair instrument processing; fixtured standalone and carrier fixtured spatiotemporal manual and/or automatizing gasoline service station fueling, upkeep and/or repair instrument processing; portable standalone and portable fixtured spationtemporal manual and/or automatizing broadcasting transmission iota minutia ionizing fuel and energy instrument processing; fixtured standalone and without limitation, of the vast numbers of spatiotemporal and geologistical: portable standalone and portable building fixture spatiotemporal manual and/or automatizing legal-trial court research reviewing instrument processing; fixtured standalone and building fixture spatiotemporal manual and/or automatizing legal-trial court research reviewing instrument processing; portable standalone and portable building fixture spatiotemporal manual and/or automatizing legal-trial court support advisory instrument processing; fixtured standalone and building fixture spatiotemporal manual and/or automatizing legal-trial court support advisory instrument processing; portable standalone and portable building fixture spatiotemporal manual and/or automatizing legal-trial court briefing writ of ceast-and-desist filing instrument processing; fixtured standalone and building fixture spatiotemporal manual and/or automatizing legal-trial court briefing writ of ceast-and-desist filing instrument processing; portable standalone and portable building fixture spatiotemporal manual and/or automatizing legal-trial court briefing writ of sequestration filing instrument processing; fixtured standalone and building fixture spatiotemporal manual and/or automatizing legal-trial court briefing writ of sequestration filing instrument processing; portable standalone and portable building fixture spatiotemporal manual and/or automatizing legal-trial court briefing writ of injunction filing instrument processing; fixtured standalone and building fixture spatiotemporal manual and/or automatizing legal-trial court briefing writ of injuntion filing instrument processing; portable standalone and portable building fixture spatiotemporal manual and/or automatizing legal-trial court briefing writ of prohibition filing instrument processing; fixtured standalone and building fixture spatiotemporal manual and/or automatizing legal-trial court briefing writ of prohibition filing instrument processing; portable standalone and portable building fixture spatiotemporal manual and/or automatizing legal-trial court briefing writ of habeas corpus filing instrument processing; fixtured standalone and building fixture spatiotemporal manual and/or automatizing legal-trial court briefing writ of habeas corpus filing instrument processing; portable standalone and portable building fixture spatiotemporal manual and/or automatizing legal-trial court briefing writ of summons filing instrument processing; fixtured standalone and building fixture spatiotemporal manual and/or automatizing legal-trial court briefing writ of summons filing instrument processing; standalone and building fixture spatiotemporal manual and/or automatizing legal-trial court briefing writ of error filing instrument processing; portable standalone and portable building fixture spatiotemporal manual and/or automatizing legal-trial court briefing writ of election filing instrument processing; fixtured standalone and building fixture spatiotemporal manual and/or automatizing legal-trial court briefing writ of election filing instrument processing; portable standalone and portable building fixture spatiotemporal manual and/or automatizing legal-trial court subpeona pre-trial discovery instrument processing; fixtured standalone and building fixture spatiotemporal manual and/or automatizing legal-trial court subpeona pre-trial discovery instrument processing; portable standalone and portable building fixture spatiotemporal manual and/or automatizing legal-trial court subpeona pre-trial deposition instrument processing; fixtured standalone and building fixture spatiotemporal manual and/or automatizing legal-trial court subpeona pretrial deposition instrument processing; portable standalone and portable building fixture spatiotemporal manual and/or automatizing legal-trial court object argument proceeding instrument processing; fixtured standalone and building fixture spatiotemporal manual and/or automatizing legal-trial court object argument proceeding instrument processing; portable standalone and portable building fixture spatiotemporal manual and/or automatizing legal-trial court summary adjudication instrument processing; fixtured standalone and building fixture spatiotemporal manual and/or automatizing legal-trial court summary adjudication instrument processing; portable standalone and portable building fixture spatiotemporal manual and/or automatizing legal-trial court jury peer findings and adjudication instrument processing; fixtured standalone and building fixture spatiotemporal manual and/or automatizing legal-trial court jury peer findings and adjudication instrument processing; portable standalone and portable building fixture spatiotemporal manual and/or automatizing legal-appellate court research reviewing instrument processing; fixtured standalone and building fixture spatiotemporal manual and/or automatizing legal-appellate court research reviewing instrument processing; portable standalone and portable building fixture spatiotemporal manual and/or automatizing legal-appellate court support advisory instrument processing; fixtured standalone and building fixture spatiotemporal manual and/or automatizing legal-appellate habeas corpus filing instrument processing; fixtured standalone and building fixture spatiotemporal manual and/or automatizing legal-appellate court briefing writ habeas corpus filing instrument processing; portable standalone and portable building fixture spatiotemporal manual and/or automatizing legal-appellate court subpeona pre-trial discovery instrument processing; fixtured standalone and building fixture spatiotemporal manual and/or automatizing legal-appellate court subpeona pre-trial discovery instrument processing; portable standalone and portable building fixture spatiotemporal manual and/or automatizing legal-appellate court subpeona pre-trial deposition instrument processing; fixtured standalone and building fixture spatiotemporal manual and/or automatizing legal-appellate court subpeona pre-trial deposition instrument processing; portable standalone and portable building fixture spatiotemporal manual and/or automatizing legal-appellate court trial object argument proceeding instrument processing; fixtured standalone and building fixture spatiotemporal manual and/or automatizing legal-appellate court trial object argument proceeding instrument processing; portable standalone and portable building fixture spatiotemporal manual and/or automatizing legal-appellate court trial judge summary adjudication instrument processing; fixtured standalone and building fixture spatiotemporal manual and/or automatizing legal-appellate court trial judge summary adjudication instrument processing; portable standalone and portable building fixture spatiotemporal manual and/or automatizing legal-appellate court trial judge findings and adjudication instrument processing; fixtured standalone and building fixture spatiotemporal manual and/or automatizing legal-appellate court trial judge findings and adjudication instrument processing; portable standalone and portable building fixture spatiotemporal manual and/or automatizing legal-supreme court research reviewing instrument processing; fixtured standalone and building fixture spatiotemporal manual and/or automatizing legal-supreme court research reviewing instrument processing; portable standalone and portable building fixture spatiotemporal manual and/or automatizing legal-supreme court support advisory instrument processing; fixtured standalone and building fixture spatiotemporal manual and/or automatizing legal-supreme court support advisory instrument processing; portable standalone and portable building fixture spatiotemporal manual and/or automatizing legal-supreme court briefing writ corpus filing instrument processing; portable standalone and portable building fixture spatiotemporal manual and/or automatizing legal-supreme court subpeona pre-trial discovery instrument processing; fixtured standalone and building fixture spatiotemporal manual and/or automatizing legal-supreme court subpeona pre-trial discovery instrument processing; portable standalone and portable building fixture spatiotemporal manual and/or automatizing legal-supreme court subpeona pre-trial deposition instrument processing; fixtured standalone and building fixture spatiotemporal manual and/or automatizing legal-supreme court subpeona pre-trial deposition instrument processing; portable standalone and portable building fixture spatiotemporal manual and/or automatizing legal-supreme court trial object argument proceeding instrument processing; fixtured standalone and building fixture spatiotemporal manual and/or automatizing legal-supreme court trial object argument proceeding instrument processing; portable standalone and portable building fixture spatiotemporal manual and/or automatizing legal-supreme court trial judge summary adjudication instrument processing; fixtured standalone and building fixture spatiotemporal manual and/or automatizing legal-supreme court trial judge summary adjudication instrument processing; portable standalone and portable building fixture spatiotemporal manual and/or automatizing legal-supreme court trial judge findings and adjudication instrument processing; fixtured standalone and building fixture spatiotemporal manual and/or automatizing legal-supreme court trial judge findings and adjudication instrument processing; and moreover, wherefrom every and all, without limitation, of the vast numbers of spatiotemporal and geologistical: portable standalone and portable building fixture spatiotemporal manual and/or automatizing in-patient and/or out-patient medical admission, trasporting, release, tracking and multivendor billing and collection instrument processing; fixtured standalone and building fixture spatiotemporal manual and/or automatizing in-patient and/or out-patient medical admission, trasporting, release, tracking and multivendor billing and collection instrument processing; portable standalone and portable building fixture spatiotemporal manual and/or automatizing in-patient and/or out-patient life-support medicine instrument processing; fixtured standalone and building fixture spatiotemporal manual and/or automatizing in-patient and/or outpatient life-support medicine instrument processing; portable standalone and portable and/or automatizing in-patient and/or out-patient preventative medicine consult instrument processing; portable standalone and portable building fixture spatiotemporal in-patient and/or out-patient emergency medicine trauma instrument processing; fixtured standalone and building fixture spatiotemporal in-patient and/or out-patient emergency medicine trauma instrument processing; fixtured standalone and space less building fixture spatiotemporal in-patient and/or out-patient preventative elective medicine consult instrument processing; fixtured standalone and space less building fixture spatiotemporal in-patient and/or out-patient preventative elective medicine consult instrument processing; portable standalone and portable building fixture spatiotemporal in-patient and/or outpatient specialty medicine consult instrument processing, fixtured standalone and building fixture spatiotemporal in-patient and/or out-patient specialty medicine consult instrument processing; portable standalone and portable building fixture spatiotemporal in-patient and/or out-patient operational surgical medicine instrument processing; fixtured standalone and building fixture spatiotemporal in-patient and/or out-patient operational surgical medicine instrument processing, portable standalone and portable building fixture spatiotemporal in-patient and/or out-patient neurological surgical medicine instrument processing; fixtured standalone and building fixture spatiotemporal in-patient and/or outpatient neurological surgical medicine instrument processing; portable standalone and portable building fixture spatiotemporal in-patient and/or out-patient pathological medicine instrument processing; fixtured standalone and building fixture spatiotemporal in-patient and/or out-patient pathological medicine instrument processing; portable standalone and portable building fixture spatiotemporal in-patient and/or out-patient cardiological medicine instrument processing; fixtured standalone and building fixture spatiotemporal in-patient and/or out-patient cardiological medicine instrument processing; portable standalone and portable building fixture spatiotemporal in-patient and/or out-patient urological trace element medicine instrument processing; fixtured standalone and building fixture spatiotemporal in-patient and/or out-patient urological trace element medicine instrument processing; portable standalone and portable building fixture spatiotemporal in-patient and/or out-patient radiological plate and film xerographic medicine instrument processing; fixtured standalone and building fixture spatiotemporal in-patient and/or out-patient chemoradiology medicine instrument processing; fixtured standalone and building fixture spatiotemporal in-patient and/or out-patient chemoradiology medicine instrument processing; portable standalone and portable building fixture spatiotemporal in-patient and/or out-patient physiological medicine instrument processing; fixtured standalone and building fixture spatiotemporal in-patient and/or out-patient physiological medicine instrument processing; portable standalone and portable building fixture spatiotemporal in-patient and/or out-patient biological medicine instrument processing; fixtured standalone and building fixture spatiotemporal in-patient and/or out-patient biological medicine instrument processing; portable standalone and portable building fixture spatiotemporal in-patient and/or out-patient cytogenetic medicine instrument processing; fixtured standalone and building fixture spatiotemporal in-patient and/or out-patient cytogenetic medicine instrument processing; portable standalone and portable building fixture spatiotemporal in-patient and/or out-patient fertility medicine instrument processing; fixtured standalone and building fixture spatiotemporal in-patient and/or outpatient fertility medicine instrument processing; portable standalone and portable building fixture spatiotemporal in-patient and/or out-patient preventative medicine instrument processing; fixtured standalone and building fixture spatiotemporal in-patient and/or outpatient preventative medicine instrument processing; portable standalone and portable building fixture spatiotemporal in-patient and/or out-patient alternative medicine instrument processing; fixtured standalone and building fixture spatiotemporal in-patient and/or out-patient alternative medicine instrument processing; portable standalone and portable building fixture spatiotemporal in-patient and/or out-patient psychological preventative medicine instrument processing; fixtured standalone and building fixture spatiotemporal in-patient and/or out-patient psychological preventative medicine instrument processing; portable standalone and portable building fixture spatiotemporal in-patient and/or out-patient psychological rehabilitative medicine instrument processing; fixtured standalone and building fixture spatiotemporal in-patient and/or out-patient psychological rehabilitative medicine instrument processing; portable standalone and portable building fixture spatiotemporal in-patient and/or out-patient surgical recovery medicine instrument processing; fixtured standalone and building fixture spatiotemporal physical rehabilitation medicine instrument processing; fixtured standalone and building fixture spatiotemporal in-patient and/or out-patient physical rehabilitation recovery medicine instrument processing; portable standalone and portable building fixture spatiotemporal home health care medicine instrument processing, fixtured standalone and building fixture spatiotemporal home health care medicine instrument processing; portable standalone and portable building fixture spatiotemporal hospice care medicine instrument processing, fixtured standalone and building fixture spatiotemporal hospice care medicine instrument processing; portable standalone and portable building fixture spatiotemporal prescription drug ordering, filling, distribution and reodering, refilling, transport redistribution inclusive of billing and collection instrument processing; fixtured standalone and building fixture spatiotemporal prescription drug ordering, filling, distribution and reodering, refilling, transport redistribution inclusive of billing and collection instrument processing; portable standalone and portable building fixture spatiotemporal major medical orthopedic surgical instrument processing; fixtured standalone and building fixture spatiotemporal major medical orthopedic surgical instrument processing; portable standalone and portable building fixture spatiotemporal major medical orthoscopic surgical instrument processing; fixtured standalone and building fixture spatiotemporal major medical orthoscopic surgical instrument processing; portable standalone and portable building fixture spatiotemporal major medical dental surgical instrument processing; fixtured standalone and building fixture spatiotemporal major medical dental surgical instrument processing; portable standalone and portable building fixture spatiotemporal major medical vision surgical instrument processing; fixtured standalone and building fixture spatiotemporal major medical vision surgical instrument processing; portable standalone and portable building fixture spatiotemporal proprietary and/or group office preventative medical consult multiport invoice billing and collection instrument processing; fixtured standalone and building fixture spatiotemporal proprietary and/or group office preventative medical consult multiport invoice billing and collection instrument processing; and wherefrom further every and all, without limitation, of the vast numbers of spatiotemporal and geologistical: portable standalone and portable building fixture spatiotemporal personal and/or commercial insurance auditory and spontaneous real-estate auditory and spontaneous real-estate inspection tangible property assessment and verification instrument processing; inclusive of every and all, without limitation, income, capital gains, taxes, charitable contribution, endowment, foundation, inheritance, transactional, estate and/or social security entitlement automated teller machine and/or so-called electronic deposit, withdrawing, transporting, letter of crediting, equity lines, credit lines, revolving credit lines, credit cards, debit cards, prepaid debit cards, check draft cards, certified check drafting, traveling check drafting, merchant, commercial, retail and/or mortgage banking, securities and insurance instrument processing inclusive of, without limitation, every and all variant fixed and portable wire-less and wire jack line pre-paid telephony cards and/or services services wherefrom every and all comprehensively aforementioned are heretofore antiquated, archaic, ancient history and superannuated techniques, methods and processes heretofore proliferating so-called telecommunications among depositors in locale fashion in an effort at further propagating boisterous, bolstering, voracious, raptorial, pretentious, portentous and pretentious proliferation of speciously fruitless heretofore so-called communications and/or telecommunications; wherefrom it is clearly an undeniable and evidentiary findings of fact, documented reference, logical scientific deduction and intuitive analytical reasoning that the heretofore highly dynamic and volatile holistic econometric marketplace environment pleads and years for invoking creatively inspired innovation wherefrom hereto concretizing via consummate melioristic logical positivism devotional praxis and timely constructive reduction to practice an innovativley novel unobvious, unknown, unforeseen and unprecedented real-time processing and/or reprocessing of data and/or information via continuous uptime steady state ubiquitous automatizing instantaneous real-time transmission and transport converter receiver conduit unified real-time microprocessing of UCMOST™ information technologies which are infinitely and unequivocally comprehensively suitable, generally pertinent and broadly useful to supplant every and all heretofore antiquated, archaic, ancient history and superannuated methods, techniques and preconceived notions of the following: retrieving; converting; formatting; processing; storing; gathering; compiling; tabulating; casting; calculating; preparing; editing; tracing; verifying; submitting; confirming; validating; booking; classifying; categorizing; adjusting; shooting; running; releasing; posting; compressing; presenting; releasing; playing; displaying; projecting; broadcasting; syndicating; whereas, moreover inclusive of; without limitation, supplanting every and all antiquated, archaic, ancient history and superannuated preconceived notions of the following: reretrieval; retransport; reconversion; reformatting; reprocessing; resaving; restoring; reidentifying; regathering, resorting; reorganizing; recompiling; retabulating; recasting; recalculating; repreparing; reediting; retracing; reverifying; resubmitting; reconfirming; revalidating; rebooking; reclassifying; recategorizing; readjusting; realtering; rerevising; rechanging; recharging, rebilling, recollecting, reproducing: recomposing, reconducting, reproofing; refiltering; repressing; republishing; recataloging; reindexing; rescripting; relocating; reshooting; rerunning; rereleasing; reposting; recompressing; representing; rereleasing; replaying; redisplaying; reprojecting; rebroadcasting; resyndicating; wherefrom, hereto collectively innate conception, terminological conveyance, indivisible rubrical, syntactic oralformulaic, systematic arrangement, artistic construct, melodious lyrics, denominative literateness and thereat proprietary multiport revolving chambered hunting metallic track encasing hermetic new software lock up cast casing constrained real-time microprocessor engineering machine language unicore operating system software computing block keyhole combinational code heretofore and hereafter apprehends UCMOST™ real-time processing and/or reprocessing; proprietary trademark and service mark is exclusive proprietary intellectual property belonging exclusively and unequivocally to Juan Carlos Castro. Wherefrom hereto aforementioned UCMOST™ real-time processing and/or reprocessing automatizing real-time holistically steady state synchronized ubiquitous continuum sub-loculated cyclical parallel redundancy cosmos robotizing unified real-time microprocessor computer logic instructions propagating, promulgating and proclaiming universal dominion isomorphic domain rubricated pragmatic sanction over tens of thousands of different instruments are traded on several dozen physical, electronic virtual exchange within the so-called U.S. alone, and several thousand mutual find shares are offered from tens of thousands of investment management companies which heretofore continuously, maliciously and perniciously engage in baiting, tempting and entrapping general depositors to utilize these variant forms of highly-complex, fragmented, antiquated, archaic, ancient portentous and pretentious conceptual aids. Moreover, several thousands of additional instruments are traded on many dozens of other exchanges in Europe and the Far East, and other physical and virtual exchanges are hereto discovered prevalent in Canada and South America whose scope of coverage includes government managed trading of bond oriented instruments. Whereas, it is an undeniable and evidentiary findings of fact, documented reference, logical scientific reasoning and intuitive analytical reasoning that heretofore there exists a physical or virtual market wherever a transaction is made involving financial instrument transactional exchange data and transactional exchange information on security instruments which is necessarily of interests to depositors because of the perpetual unmet need for compassion, accuracy, quality, integrity, honor, timeliness, relevance, transparency, reliabilty, verifiability, comprehensiveness, understandability and assurance hereafter comprehensively suitable, generally pertinent and broadly useful to every and all directly quantifiable in numismatic sums in definite discrete integer metric system terms applicable to each and every registered, listed and exchanged instruments found prevelant within a capital market wherein there are few, if any, prior-art references which heretofore attempted to recognize or address tremendously long-held and enormously heart-felt unmet needs associatively hereto attributed, ascribed, literalized, codified, canonized with compassion, accuracy, quality, integrity, honor, timeliness, relevance, transparency, reliabilty, verifiability, comprehensiveness, understandability and assurance of real-time data processing instrument transactional exchange and real-time information origination transactional exchange of instruments related to physical and virtual exchanges which heretofore exist entailing, encompassing, comprising, involving, impacting and/or effecting multifaceted sectors and multidimensional industries within, throughout and transcending so-called national sovereign borders of every and all industrialized, developed and developing free-market commerce and trade bloc economies of a single holistically econometric marketplace environment. For instance, withn so-called U.S. Pat. No. 5,987,432 Zusman et al. disclose a fault-tolerant central ticker plant system for distributing financial market security instruments transactional exchange data that receives ticker feed data from many exchanges throughout the world, processes and formats the received data, and then distributes or broadcasts the data to regional customers in the form of security discloses a commodity trade exchange having several local computerized trade exchanges located in at least two different countries and interconnected by artificial satellite communication. Sibley's invention provides consolidated market data to the trader by means of user terminals, thereby permitting trades based on knowledge of the consolidated market instead of the local market. However, Sibley does not consider the collection, processing and distribution of data from scores of world-wide exchanges trading in tens of thousands of different security instruments involving hundreds of thousands of instruments other than commodity security contracts. Whereas furthermore, within so-called U.S. Pat. No. 5,101,353, Mayiam A Lupien et al. disclose an automated system for improving market liquidity via computer-implemented trading apparatus related to data processing equipment to place trading security instrument orders in external securities markets and via automated brokers that execute trades directly between system users. Lupien et al. consider solutions to the external market liquidity problems arising from large institutional trades and do not consider the collection and distribution of world-wide security instruments transactional exchange data. Whereas moreover, within so-called U.S. Pat. No. 4,674,044, Leslie P. Kalmus et al. disclose an automated securities trading system that operates as a virtual trading floor for selected securities. Their system reports executed trade details to the customer and to national security equity stock price reporting systems and responds to changes in security instrument trading prices by updating all relevant internal parameters. Kalmus et al. provide a solution to the automated trade-quality problem known for virtual exchanges but neither consider nor suggest methods for rapid and accurate accumulation of world-wide exchange transaction data for distribution to regional users. Whereas furthermore, within so-called U.S. Pat. No. 5,038,284, Robert M. Kramer discloses a method and apparatus for conducting trading transactions in a network of portable trading stations. Kramer teaches a computer-assisted pit trading system that uses portable computer terminals to real-time automatizingally report all security trades without the usual risk of confusion or error associated with the loud and boisterous pit environment of commodity exchange floors. Some practicioners propose solutions to the derivative oriented capital market data distribution problem, otherwise denominated the so-called portfolio tracking problem in financial market security apparatus for storing and generating financial information employing user specified input and output formats that specifically becomes an advanced financial reporting and analysis software package that collects organizes, manages and consolidates financial data and provides user defined capabilities for creating financial and corporate reports. Whereas accordingly, within so-called U.S. Pat. No. 4,566,066, Frederic C. Towers discloses a security valuation system that employs a general purpose digital computer to produce securities portfolio valuation schedules for many simultaneous users. Like Lyons et al., Towers merely assumes accurate daily updates to the basic instruments transactional exchange data without considering high-quality control problems. More pertinently to the global financial high-quality problem, numerous practitioners suggest improved local market quotation systems. Whereas furthermore, within so-called U.S. Pat. No. 4,473,824, Richard N. Claytor discloses a security price quotation system for distributing security instrument transactional exchange data. Claytor's system includes a transceiver for receiving security instrument transactional exchange data and for distributing selected data to users possessing handheld portable receiving and display devices. Claytor essentially discloses a ticker-tape transmitter with portable receiving terminals suitable for tracking trading activity related to a few user-selected securities and neither recognizes nor addresses techniques suitable for compiling and distributing world-wide security instrument transactional exchange data for tens of thousands of different security instruments. Whereas furthermore, within so-called U.S. Pat. No. 3,611,294, Jerry D. O'Neill et al. disclose a system of disseminating security instrument transactional exchange data from a central distribution station to a plurality of portable radio receivers. Again, O'Neill et al. merely disclose a method for transmitting raw exchange “ticker” quotation data feeds to individuals users who may then accumulate data for a few user-selected security instruments. Whereas additionally, within so-called U.S. Pat. Nos. 5,045,848 and 4,677,434, Anthony C. Fascenda discloses a similar system for encoding and distributing security instrument transactional exchange data by commercial radio transmitter to a plurality of specially equipped portable radio receivers. Fascenda employs FM broadcast spectra to transmit ticker data interleaved with a repeated stream of derivative security instrument transactional exchange data. Fascenda considers data processing and distribution of high-quality world-wide security instrument transactional exchange data. Early practitioners in the art considered the limited problem of so-called “ticker” data feed distribution to regional center; via wire jack line which hereto are inefficient, ineffective, antiquated, archaic, ancient history and superannuated techniques, methodologies and/or processes. For instance, within so-called U.S. Pat. No. 3,082,402, J. R. Scantlin discloses a security quotation apparatus that uses telephone lines to distribute exchange ticker data to regional customers who may then accumulate, process and distribute security instrument data to their clients. Whereas additionally, within so-called U.S. Pat. Nos. 3,689,872, and 3,513,442, Frank W. Sieracki discloses a security instrument transactional exchange data and quote-board multiplex system that permits regional users to request and receive specific security instrument transactional exchange data on requisite from a central ticker data stream using telephone lines. Whereas furthermore, within so-called U.S. Pat. No. 4,942,616, Thomas Linstroth et al. discloses an interactive synthesized-speech quotation system for brokers that is suitable for automated response to clients who call in telephone price quote requests for individual securities. Their system offers human-speech response to such requests without human intervention. Nothing in either of the two above aforementioned prior-art references nor any other aforementioned prior-art reference is readily suitable for accumulating processing and distributing security instrument transactional exchange data of the quality and the scale necessary to satisfy requisites demands arising from the recent improvements in world-wide trading technology and thus none of the aforementioned completely resolved the tremendously long-held and heart-felt unmet needs wherefrom hereto found and completely resolved in the relevant art. Such a system must be completely reliable and therefore tolerant of any possible system element failures. Data distribution must occur via the system without significant delay. Data errors must be detected and corrected, either real-time automatizingally or with cued manual intervention. Finally, such a system must provide for adding ticker data streams from new physical and virtual exchanges and must provide for customized distribution that is responsive to user command. Whereas accordingly, within so-called U.S. Pat. No. 5,970,476, Fahey discloses a method and apparatus for industrial data acquisition related to production and indirect support product so-called U.S. Pat. No. 5, 940,807, Purcell discloses an automated and independently accessible inventory information exchange system related to a method for controlling the collection, processing, and dissemination of information to improve the means by which product and service information is exchanged between parties. Whereas furthermore, within so-called U.S. Pat. No. 5,923,552, Brown et al. disclose a system, method and computer program for facilitating the exchange of information between separate business entities that synchronize product fabrication schedules with supplier schedules related specifically to the building and construction industry. Whereas accordingly, within so-called U.S. Pat. No. 5,920,848, Schutzer et al. disclose a system and method for using intelligent agents for financial transactions, services, accounting and advice related to integrated networked performance of financial transactions with computerized methods of financial accounting. Whereas furthermore, within so-called U.S. Pat. No. 5,839,118, Ryan et al. disclose a system and method for premium optimization and loan monitoring related to linking an external computer with an illustration system of an insurance carrier and a system of an independent lending institution, via modem, to determine the optimal premium structure for a contemplated variable life insurance product and also provides for simultaneously tracking several variable life insurance policy cash values to ensure each individuals policy cash value is adequate for collateral purposes. Whereas moreover, within so-called U.S. Pat. No. 5,812,988, Sandretto discloses a system and method for jointly estimating cash flows, simulated returns, risk measures, and present values for a plurality of assets related to computer implemented processes pertaining to estimating an asset's risk and net present value that, instead of using prior-period returns to estimate risk, instead uses an assets operating, financing, and accounting characteristics, general and sector economic relations, and certain present economic conditions to create a portfolio based on the estimated asset risk and net present value. Whereas accordingly, within so-called U.S. Pat. No. 5,808,916, Orr et al. disclose a method for monitoring the environment related to the collection, integration, manipulation, modeling, and presentation of various local, regional, and/or global data related specifically to the natural environment to generate an advanced remote sensing and environmental monitoring system which rapidly acquires broad-based and accurate environmental data necessary to support cost-financial information related to techniques to allow money managers and financial analysts to easily view otherwise unmanageable amounts of complex information and in particular, security instrument transactional exchange data such as information about equities, commodities, currencies, derivatives and their related markets. Whereas moreover, within so-called U.S. Pat. No. 5,737,595, Cohen et al. disclose a distributed database system and database receiver thereof which has applicability to data communication media and relates to distribution from a central station with thematically linked data to one or more users at remote locations. Whereas furthermore, within so-called U.S. Pat. No. 5,710,889, Clark et al. disclose an interface device for electronically integrating a plurality of financial services provided at different geographical locations and in different time zones, and delivering such services directly to a user facility at any time requested by the user. Whereas moreover, within so-called U.S. Pat. No. 5,701,400, Amado discloses a method and apparatus for applying artificial intelligence technology to data stored in databases that generates diagnostics that are user definable interpretations of information in the database. Whereas additionally, within so-called U.S. Pat. No. 5,557,780, Edwards et al. disclose a programmable machine system, and in particular methods and an apparatus for determining the formats of business transactions used in entering, storing, printing, and transporting data between a plurality of users of merchandising products, goods, supplies and services using a standardized business transaction data coding scheme. Whereas accordingly, within so-called U.S. Pat. No. 5,406,475, Kouchi et al. disclose a data processing network having a plurality of independent subscribers utilizing an integrated database for storing dispersed data pertaining to business of planning, manufacturing and selling of products specifically encompassing sales dresses or bags in a clothing industry and textile raw material in an apparel industry. Wherefrom therewithal notwithstanding, it is clearly an undeniable and evidentiary findings of fact, documented reference, logical scientific deduction and intuitive analytical reasoning that nothing readily identified within the above aforementioned so-called relevant prior-art references recognized nor addressed the tremendously long-held and enormously heart-felt unmet needs in the relevant art, wherefrom herewith is a complete unequivocal absolute resolution hereto legal patent disclosure of proofed apprehension of a novel, unobvious, unknown, unforeseen, technological architectural design innovation which is a self-contained, fault-tolerant, anonymous, independent, autonomous, impartial, apolitical, streamlined, alternating scale, and inseparable, proprietary multiport revolving chambered homing binary hunting metallic track encasing hermetic data link caster dart castings constrained new software parallel redundancy cosmos robotizing unified real-time microprocessor machine language computer block whose universal dominion domain outline is comprehensively suitable, generally pertinent and broadly useful to every and all anytime, anyplace and anywhere, wherefrom hereto entailing, encompassing, comprising, involving, impacting and/or effecting automatizing real-time holistically steady state synchronized ubiquitous continuum sub-loculated cyclical parallel redundancy cosmos robotizing unified real-time microprocessor computer logic instructions propagating, promulgating and proclaiming across-the-board traversal of breakthrough technological and groundbreaking innovative developments and advancements in multifaceted and multidimensional microcosmic techniques, designs, systems, routines, devices, manners, modes, fashions, forms, formats, factors, objects, parts, segments, elements, components, constituents, ingredients, processes, methods and combinations; wherefrom moreover hereto entailing, encompassing, comprising, involving, impacting and/or effecting streamlined, alternating scale, inseparable, seamless and natural wrapping, interlacing, coiling, coupling, combining and interlocking every and all of the following: proprietary multiport revolving chambered homing binary hunting metallic track encasing hermetic data link caster dart castings constrained new end-user graphical human apostrophe interface syntactic synthesis real-time software programs block; proprietary multiport revolving chambered homing binary hunting metallic track encasing hermetic data link caster dart castings constrained new algebraic problem-solving application syntactic synthesis real-time software programs block; proprietary multiport revolving chambered homing binary hunting metallic track encasing hermetic data link caster dart castings constrained new robotizing gauge indicating guidance syntactic synthesis real-time software programs block; proprietary multiport revolving chambered homing binary hunting metallic track encasing hermetic data link caster dart castings constrained new commerce and transactional exchange methodology syntactic synthesis real-time software programs block; proprietary multiport synthesis real-time software programs block; wherefrom every and all proprietary creative original conceptions, engineering utilities, aesthetic architectural designs, authentic compositions and genuine productions of a sole legal owner; wherefrom herewith concretizing consummate and constructive reduction to practice a complete sub-loculated cyclical parallel redundancy cosmos robotizing real-time microprocessor machine language logic instructing compact integrated new software generator AND-OR closed-circuitry wheresoever transcendent EPROM, degausse and/or magnetostriction preemptively constrained ferromagnetic alloy, silicon, germanium, biodynamic and/or geomagnetic resonant soundproof and fireclay wall protective fireball impervious microcircuit epoxy casting insulated microprocessor engine machine language operating system computing block; wherefrom infinitely automatizing real-time holistically steady state synchronized ubiquitous continuum universal executive sub-compartment cyclical parallel redundancy cosmos robotizing real-time accurate, high-quality, never faulting, fully reliable, never failing, simplified and streamlined microprogrammable systematically codified microprocessor machine language logic instructions entailing, encompassing, comprising, involving, impacting and/or effecting every and all one-time programmable read-only memory (PROM) within a proprietary multiport revolving chambered homing binary hunting metallic track encasing hermetic data link caster dart castings constrained engine block protective contactor composite soundproof housing and fireclay sealed wall casting fireball imperious carnage data link caster dart castings accumulator controlling central processing unit (CPU) concretizing via conducive appendicular microelectronic templates appended, fixed, soldered, mounted, etched, embedded, copied, inscribed and/or contact printed onto every and all heretofore and hereafter mechanical and/or electrical devices, articles, apparatuses and/or megastructure microcircuit processing computing motherboards; wherefrom hereto intrinsic and integral as comprehensively suitable, generally pertinent and broadly useful within every and all automatizing high-quality holistically steady state heliocentrically synchronizing ubiquitous hunting continuum parallel redundancy cosmos robotizing unified real-time microprocessing computing protective contactor composite housing carriage devices, articles, apparatus, refractories and/or megastructures; wherefrom hereto successfully embroidering unequivocal absolute within every and all iota trace element minutia fueling and/or energizing microprocessor semi-conducting chips, whence perpetually propagating, promulgating and proclaiming galactic alternating angle conduit premised on a single alternating scale single independent portal proliferation of artificial semi-conducting microcircuit devices, articles, apparatuses, refractories and/or megastructures, wherefrom propagating traversal of every and all traditonal mechanical friction and/or chemical reaction to fuel power and energy conduit electrical and/or battery generation inclusive of every and all advanced electronic locational systematizing geological and/or seismological processes concretizing innovative wheresoever transcendent EPROM, degauss and/or magnetostriction preemptively constrained ferromagnetic alloy, silicon, germanium, biodynamic and/or geomagnetic resonant soundproof and fireclay wall protective fireball impervious microcircuit epoxy casting insulated permeability of artificial semi-conducting microcircuit devices, articles, apparatuses, refractories and/or megastructures internalizing upright orthorhombic tentacular boundless steady state roving antennule transmuting metric conversional transistor transfusing receiver concretizing high-quality holistically steady state heliocentrically synchronizing ubiquitous hunting continuum parallel redundancy cosmos robotizing digitalized galactic transmitting receiver of spatiotemporal emitted broadcasting of real-time microprocessing traversing a single independent portal refractory evincing minutia partible iota beta particle trace element wave front continuous spectrum pulse signaling transmission conveying efficient energizing and fueling powered catalytic conduits via electrogasdynamics, electrogenesis, electrohydraulic, geomagnetic, gyromagnetic, geokinetic and/or thermodynamic setting transistorized rheostat regulated transfusing partible trace element staple actualizing galactic and/or intergalactic gyroscopic axisymmetrical stabilizing self-impetus protective contactor composite housing carriage hermetic cast lock up software encased unified real-time microprocessor machine language computer block comprehensively suitable, generally pertinent and broadly useful within every and all portable rove bearing devices, articles, apparatuses and/or megastructures; wherefrom hereto collectively innate conception, terminological conveyance, indivisible rubric, syntactic oralformulaic, unique artwork, systematic arrangement, differentiated crafting, artistic construct, melodious lyrics, denominative literateness and thereat block keyhole combinational software computer code heretofore and hereafter apprehends UCMOST™, information technology, heretofore formally utilized proprietary trademark and/or service mark exclusively owned intellectual property of Juan Carlos Castro. Wherefrom hereto aforementioned UCMOST™ information technology is comprehensively suitable, generally pertinent and broadly useful to streamlined, alternating scale, inseparable, seamless and natural wrapping, interlacing, coiling, coupling, combining and interlocking every and all of the distinctively separate and traditionally exclusive specialty areas of public accounting, transport reconciling, independent auditing and financial reporting inclusive of streamlined, alternating scale, inseparable, seamless and natural wrapping, interlacing, coiling, coupling, combining and interlocking every and all of the distinctively separate and traditionally exclusive specialty areas of order-entry quotation, matching, clearance, execution, settlement and exchange of insurance, risk financing, credit, cash management, investment banking and security financial instruments hereafter comprehensively across-the-board inclusive of, without limitation, public denominative words, credits, debits, monies, currencies, time deposits, escrows, trusts, individual retirements, defined pensions, deferred contributions, social security entitlements, insurance plans, insurance cooperatives, insurance rent-a-captives; insurance captives; insurance syndicates; insurance policies, annuity contracts, mutual funds, fractional equity participation interests, scrips, strips, coupons, tracking funds, unit investment trusts, real estate investment trusts, closed-end investment pools of capital, asset-backed obligations, mortgage-backed obligations, repurchase obligations, collateralized assets, collateralized liabilities, collateralized residual equities inclusive of every and all natural derivative and/or synthetic derivative, composite, indice and/or process, wherefrom further hereto comprehensively suitable, generally pertinent and broadly useful to every and all stock, bond, option, future, forward, swap, commodity, and moreover otherwise primary metal heretofore registered and licensed physical, electronic and/or virtual so-called exchanges; wherefrom further hereto inclusive of, without limitation, every and all natural, derivative and/or synthetic hard-core air and/or liquid chemical elements such as: oxygens, hydrogens; carbons; oxidants; nitros; wherefrom further hereto inclusive of, without limitation, every and all natural, derivative and/or further hereto inclusive of, without limitation, every and all comprehensively, generally and broadly defined authentically original, first-hand, second-hand, third-hand, intermediary and/or third party appraising, rating, assessing, zoning, permitting, licensing, designing, engineering, building, constructing, inspecting, reinspecting, developing, expanding, renovating, remodeling, refurnishing, purchasing, operating, leasing, transporting and/or outright sale entailing, encompassing, comprising, involving, impacting and/or effecting every and all, without limitation, of the following private and/or governmental zoned area space residing, operating, parking and/or in-transit tangible fixtured inclusive of intangible goodwill oriented physical personal property, residential property, commercial property and real-estate property initiatives, schemes, ocurrences, happenings, interactions, processes, methods, practices, movements, proceedings, messaging, presentations, notifications, filings, submissions, records, activities, actions, events, endeavors, tasks and affairs; and physical chemical mixtures inclusive of, without limitation, concrete, steel, asphalt, clay, brick, plaster, porcelain, graphite, titanium, synthetic graphite; wherefrom, further, atmospheric, aboveground, underground, underwater, submersible, aerospace aeronautical galactic and/or aerospace aeronautical intergalactic spatiotemporal guidance hunting emotional, pshychological, physiological, pathological pathogenesis, cyclization, metalurgy, devises, devices, aeronautical, cosmological, typographical, oceanographical, bibliographic, physicalistic, biological cytogenetic, and ionizing natural, chemical, physical and behavioral geological, airway magnetic and/or thermomagnetic biohazardous regulated elements, components, constituents, factors, ingredients, processes, methods and/or combinations involving every and all inefficient, ineffective, disparate, dysfunctional, fragmented, antiquated, archaic, ancient history and superannuated initiatives, schemes, ocurrences, happenings, interactions, processes, methods, practices, movements, proceedings, messaging, presentations, notifications, filings, submissions, records, activities, actions, events, endeavors, tasks and affairs propagating heretofore illegitimate individualized criminality, illegitimate bibliolatrous criminality, illegitimate mafia organized criminality and/or unilateral, bilateral and/or multilateral transnational commissioned military armed service affairs and/or strategic covert operations hereafter effecuated exclusively via transnational validated heliocentrical exclusively remote encapsulating and securing every and all, without limitation, forms of recoiling reprecussion interfering explosive, damaging, detrimental, obstructing, obscurant, oppressing and/or debilitating blasts, light waves, heat waves, air waves, radio waves, artificial satellite waves, sound waves, ground waves, oceanic waves, pulsating vibrations and/or recoiling reprecussion atmospheric, aboveground, underground, abovewater, submersible, aerospace lunar galactic, aeronautical translunar galactic and/or aeronautical intergalactic partible particle beta trace element residue, fallout, earthquakes, floods, avalanches, mud slides, fire storms, magnetic storms, electrical storms, ice storms, rain storms, hail storms, thunder storms, tornoadoes, hurricanes and/or typhoons, further inclusive of, without limitatin, airway, airspace, aerospace and/or aeronautical preclusive, oppressing, repressing, obstructing, intefering and/or precluding normal transnational living standards, food supplies, water supplies, ways of life and/or walk of life econometric transactional forms, formats, standards, protocols, technologies, methodologies and/or processes which hereafter requisite normal operating real-time transmission and/or receiver transpondent transducing transitory processing and/or reprocessing attributes entailing, encompassing, comprising, involving, impacting and/or effecting which assist in further preventing every and all natural meteorlogical, electrical, accounting, communicating, transporting, energizing, reconciling, fueling, treasuring, distributing and financing real-time processing and/or reprocessing functionalities outside of the sealed, encapsulated and secured area targeted for magneton cyclometric band controlled, administered, managed and operated high-technology initiatives, schemes, ocurrences, happenings, interactions, processes, methods, practices, movements, proceedings, messaging, presentations, notifications, filings, submissions, records, activities, actions, events, endeavors, tasks and affairs; whereas, further involving every and all tangible inclusive intangible portable and/or fixtured continuous spectrum and/or orthorhombic conic section projection plane surface, nautical, ground wave, sound wave, airway, airspace, aerospace and/or aeronautical plane low-frequency, high-frequency, infrared, ultraviolet and/or geomagnetic weaponry inclusive of, without limitation, hereafter supplanting every and all so-called AEGIS, so-called Kidd-class, and so-called Kilo-class systems, heretofore utilized in, without limitation: bumptious; threatening; intimidating; tyrannizing; interfering; vision goggles; vision masks; vision scopes; gaseous masks; gaseous suits; bayonets; arms; guns; rifles; equalizers; ammunitions; artillery; muzzlers; star shells; ballistics; dynamites; bombs; mines; bouncing mines; mines; grenades; lasers; cannons; barrels; ions; iodines; biomechanics; bioastronautics; pathogens; magnetics; bibliotics; cytogenetics; bionics; biophysics; biochemical; hydraulics; airborne pathogens; gasses; missles; shells; rockets; stealth articles; jetfighters; jetfighters helicopters; fighter-bombers; tanks; amphibious articles; vehicles; destroyers; carriers; chambers; launchers; silencers; artificial satellites; ships; submarines; shuttles; biosatellites; capsules; pods; pads; combs; trains; silos; megastructures; robotics; bionics; apparatuses; articles; whereas, inclusive of, without limitation, every and all physical energizing and/or fueling power utility mechanical to electrical energy catalysts whether every and all standalone and/or combinatorial forms of traditional energizing and/or fueling power are concretizing via atmospheric, earth based, above sea water and/or submersible oceanic exploring, blasting, drilling, mining, extracting, piping, hauling, driving, shipping and/or airway transporting, mixing, refining, distilling, bottling and distributing and/or steam, coal, dam, gasoline, diesel, octane, mixed gasoline and oil, or propagating traverse via every and all traditonal mechanical friction and/or chemical reaction to electrical and/or rocket fuel energy via conduit electrical generation and/or electrical battery, wherefrom hereto via every and all advanced electronic locational systematizing geological and/or seismological processes concretizing innovative wheresoever transcendent EPROM, degauss and/or magnetostriction preemptively constrained ferromagnetic alloy, silicon, germanium, biodynamic and/or geomagnetic resonant soundproof and fireclay wall protective fireball impervious microcircuit epoxy casting insulated permeability of artificial semi-conducting microcircuit devices, articles, apparatuses, refractories and/or megastructures internalizing upright orthorhombic tentacular boundless steady state roving antennule transmuting metric conversional transistor transfusing receiver concretizing high-quality holistically steady state heliocentrically synchronizing ubiquitous hunting continuum parallel redundancy cosmos robotizing digitalized galactic transmitting receiver of spatiotemporal emitted broadcasting of real-time microprocessing traversing a single independent portal refractory evincing minutia partible iota beta particle trace element electrohydraulic, geomagnetic, gyromagnetic, geokinetic and/or thermodynamic rheostat regulated staple galactic iota minutia fueled and powered apparatuses, articles and/or megastructures; wherefrom hereto additionally inclusive of every and all of the following atmospheric multifaceted: atmospheric, aboveground, underground, underwater, submersible, aerospace aeronautical galactic and/or aerospace aeronautical intergalactic spatiotemporal sovereign private and/or governmental, real estate zoned tangible property, inclusive of, without limitation, every and all rugged, rough, economy, sport and/or luxury one-wheel, two-wheel, three-wheel, four-wheel, five-wheel, six-wheel, seven-wheel, eight-wheel, nine-wheel, ten-wheel eleven-wheel, twelve-wheel, thirteen-wheel, fourteen-wheel, fifteen-wheel, sixteen-wheel, seventeen-wheel, eighteen-wheel and moreover every and all increasing wheel-based number inclusive of one-engine, two-engine, three-engine, four-engine, five-engine, six-engine, seven-engine, eight-engine, nine-engine, ten-engine, twelve-engine, eleven-engine, twelve-engine, thirteen-engine, fourteen-engine, fifteen-engine, sixteen-engine, seven-teen-engine, eighteen-engine and furthermore every and all increasing engine-based number inclusive of one-rocket, two-rocket, three-rocket, four-rocket, five-rocket, six-rocket, seven-rocket, eight-rocket, nine-rocket, ten-rocket, twelve-rocket, eleven-rocket, twelve-rocket, thirteen-rocket, fourteen-rocket, fifteen-rocket, sixteen-rocket, seven-teen-rocket, eighteen-rocket, inclusive of every and all increasing ionizing rocket-based number and/or ionizing star ships; wherefrom further, inclusive, without limitation, concretizing every and all spatiotemporal hunting axia stabilizing and equilibrating propagating never faultering and never failing, timely, safe, reliable and secure self-impetus advancing, braking, reversing, ascending, descending, driving, banking, steering, directing, turning, targeting, maneuvering, throttling, and/or controlling every and all iota minutia ionizing fuel and engery powered, thrusted and/or propelled surface-to-surface, surface-to-air and/or air-to-surface articles, apparatuses and/or megastructures via airspace, airwaves, ground waves, highway, subway, parkway, passage, toll booth, tunnel, conduit, channel, pipe, aqueduct, road, roadway, railroad and/or rail-line traverse access way space, bed, surface, pavement, traverse and/or propagating on and/or off traverse access way space inclusive of, without limitation, every and all supersonic jet, speed jet, executive jet, pleasure jet, jetliner, airliner, helicopter, snowski, waterski, cycle, car, auto, seacraft and/or star ship transport apparatuses, articles and/or vehicles; physical communicative utilities such as electrograph, electrostatic, electrothermal, photographic, xerographic, thermographic, thermostatic, thermoelectric, telecast, teletext, teletype, televise, telefacsimile, telegraphy, telemetry, telephony, wire, cable, fiber, film, optic, glass, infrared, radio, television, cinema, radar and/or artificial satellite; inclusive of every and all basic, elementary, rudimentary, advanced and/or panacean cutting-edge combinations of natural elements, artificial elements, natural components, artificial components, natural factors, artificial factors, natural constituents, artificial constituents, natural ingredients and artificial ingredients entialing, encompassing, comprising, involving, impacting and/or effecting every and all combinatorial of the following: agriculture; construction; foods;; beverages; lumber; mining; natural resources; textiles; primary metals; fabrics; commercial machinery; computing devices; electronics, chemicals; physicals; transportation equipment manufacturing instruments; railroad and/or transit, air, land and water transportation; communications; utilities; wholesale; retail; banking; finance; insurance; real estate; general services; public administration; non-classifiables; wherefrom further, hereto every and all aforementioned are heretofore comprehensively suitable, generally pertinent and broadly useful in apprehending and cognizably appearing, recognizing, identifying, acknowledging, associating, filtering, sorting, organizing, conceptualizing, understanding and comprehending abstract representational every and all, without limitation, real-time processing of data and/or information receiver for which every and all of every and all basic, elementary, rudimentary, advanced, ground breaking, breakthrough and/or panacean cutting-edge combinatorial elements, components, factors, constituents, ingredients, functions, constants, ratios, variables and functionalities entialing, encompassing, comprising, involving, impacting and/or effecting every and all known and unknown and/or developed and undeveloped linear and/or non-linear associative and/or sequential arithmetic, mathematical, square root, algebraic, logrithmic, spatial, aesthetic, geometrical, trigonometrical, discrete definite integer raised variable powered, calculus, statistical, advanced calculus inclusive of every and all combinatorial elements, components, factors, constituents, ingredients, functions, constants, sequences and/or variable coefficients identity matrix array mathematical, algebraic and/or factual metaanalysis combined with precision driven statistical infererences, inclusive of, without limitation, advanced differential calculus precisely evincing every and all numeric metric system dimensional descriptive figure denumerable discrete integer functions, constants, ratios, variables and functionalities, of every and all one or many wherefrom maxima and minima definite and discrete integer and integral whose integrands are undeniably, referenced, logically, scientifically and intuitively functions of independent varilables and/or dependent variables inclusive of every and all of their systematic differential variation derivatives and/or systematic differential variation synthetic derivatives, further entailing, encompassing, comprising, involving, impact and/or effecting every and all finite limits and infinite continuum differentiation and integration of every and all numeric metric system dimensional descriptive figure denumerable discrete integer functions, constants, ratios, variables and functionalities to ascertain, achieve and/or accomplish utmost conclusive evidentiary, undeniable, referenced, logical, scientific and intutive assurance entailing, encompassing, comprising, involving, impacting and/or effecting discrete and definite integer high-quality, pure integrity, real value and true assurance of utmost precision driven denumerable metric sysetm measurements, wherefrom hereto further entailing, encompassing, comprising, involving, impacting and/or effecting every and all, without limitation, real-time processing of data and/or information receiver wherefrom whichever are hereto discovered and/or concretizing as comprehensively suitable, generally pertinent and broadly useful to every and all transactional exchanges within, throughout and transcendent among the universal citizenry residing and/or operating within every and all of the so-called national sovereign borders of every and all of the industrialized, developed and developing free-market commerce and trade bloc economies within, throughout and transcending the evidentiary atmospheric geographical territories of a single holistically econometric marketplace environment, wherefrom hereto innate conception, terminological conveyance, indivisible rubric, syntactic oralformulaic, unique artwork, systematic arrangement, differentiated crafting, artistic construct, melodious lyrics, denominative literateness and thereat proprietary multiport revolving chambered binary hunting metallic track encasing hermetic lock up cast casing constrained unified real-time microprocessor and service mark is exclusive proprietary intellectual property belonging exclusively and unequivocally to Juan Carlos Castro. Wherefrom every and all aforementioned PUBLIC FINANCIALS™ instruments inherently entail, encompass, compris, involve, impact and/or effect every and all whichever transactional exchange of every and all real-time processing and/or reprocessing of data and/or information receiver anytime, anyplace and anywhere within a single holistically econometric marketplace environment wherefrom hereto same terminological denominative is discovered, apprehended and concretizing as comprehensively suitable, generally pertient and broadly useful to every and all universal citizenry, wherefrom collectively moreover herewith innate conception, terminological conveyance, indivisible rubric, syntactic oralformulaic, unique artwork, systematic arrangement, differentiated crafting, artistic construct, melodious lyrics, denominative literateness and thereat proprietary multiport revolving chambered binary hunting metallic track encasing hermetic lock up cast casing constrained unified real-time microprocessor machine language object block keyhole combinational software computer code heretofore and hereafter apprehends respectively aforementioned PUBLIC FINANCIALS™ instruments necessarily integrated, critically important and increasing integral within every and information wherefrom collectively moreover herewith innate conception, terminological conveyance, indivisible rubric, syntactic oralformulaic, unique artwork, systematic arrangement, differentiated crafting, artistic construct, melodious lyrics, denominative literateness and thereat proprietary multiport revolving chambered binary hunting metallic track encasing hermetic lock up cast casing constrained unified real-time microprocessor machine language object block keyhole combinational software computer code heretofore and hereafter apprehend; PUBLIC FINANCIALS™ statements, proprietary trademark and service mark is exclusive proprietary intellectual property belonging exclusively and unequivocally to Juan Carlos Castro. Moreover, respective terminological denominate combinatorial elements, components, factors, ingredients and/or constituents aforementioned PUBLIC FINANCIALS™ instruments inclusive of every and all necessarily integrated, critically important and increasingly integral aforementioned PUBLIC FINANCIALS™ statements further undeniably, logically, scientifically and intuitively derives comprehensively suitable, generally pertinent and broadly useful understanding and comprehending every and all heretofore known and/or unknown inclusive of every and all developed and/or undeveloped conretizing abstractive conceptualized representational tangible and/or intangible literary, melioristic logical positivism, melodius, theatrical, aesthetic and artistic works inclusive of, without limitation, every and all of the following; high technology; identic; diplomatics; scientistic; thoughts; notions; ideas; concepts; conceptions; devises; devices; metaphysics; metaanalysis; philosophies; metaethic; elemental; object; rudimentary; methodical; robotics; philology; geological; horological; typology; typography; magnetic levitation; magneton; ecological; econometrics; existentials; metrology; meteorological; metamathematical; geometrics; numismatics; heuristics; identic; linguistic; metaphysical; metalurgy; seismology; nautical; astrological; cosmological; bibliographic; oceanographic; astronomical; aeronautical; urology; semantics; chemical; ionizing; biologic; pathogenic; sociological; cytogenetic; commerce; governance; law; medicine; social contract; social engineering; social psychiatry; social psychology; social science; social service; social geography; social history; social governance; sociobiological; sociocultural; social economic; sociolinguistic; sociometry; sociopolitical; socioreligious; theological; sociopsychologica; paleoecology; paleography; anthropical; phytological; behavioral; pathological; physiological; pyschological; metalography; phonetic; physicalistics; zoology; metalinguistics; and/or other heretofore utilization of antiquated, archaic, ancient history and superannuated identifying, organizing, categorizing, indexing, cataloging and/or processing cards, records, files, folers, disks, dishes, drives, cabinets, drawers, shelves or otherwise entailing, encompassing, comprising, involving, impacting and/or effecting hesistant, restricting, restraining, delayed, time-lagged, antiquated, archaic, ancient history and superannuated methodological pooling and batch group processing transmission to/from converting reciever traverse conduit data transport processing heretofore concretizing cognizably appearing, recognizing, identifying, acknowledging, associating, filtering, sorting, organizing, conceptualizing, understanding and/or comprehending all of whose inherent aim, letter, nature, breadth, sound, depth, spirit and scope benefits from efficiencies herewith useful via invoking aforementioned UCMOST™ information technology, every every and all of the tens of hundreds of thousands of holding and/or fixtured, of the following: so-called proprietary; so-called partnership; so-called company; so-called firm; so-called corporation; so-called incorporation; so-called commercial enterprise; so-called franchise; so-called union; so-called thrift; so-called group; so-called board; so-called institute; so-called convention; so-called bi-cameral; so-called society; so-called chamber; so-called not-for-profit; so-called foundation; so-called endowment; so-called association; so-called league; so-called consortium; so-called commission; so-called agency; so-called bureau; so-called department; so-called court; so-called embassy; so-called section; so-called town; so-called locale; so-called city; so-called municipal; so-called metropolis; so-called county; so-called district; so-called province; so-called state; so-called federal; so-called country; so-called nation; so-called transnational; so-called multinational; so-called federation; so-called confederation; whichever private individuals, private and/or public commercial, labor unionized, religious sect, political ideological, group and/or board associational and/or public governance legal and/or status of existence below mentioned members of a universal citizenry, every and all of whom are respectively, independently, autonomously, evidently, undeniably, logically, scientifically and intuitively found to be inevitably necessary and increasingly integral living and breathing biological organisms within a capital market heretofore and hereafter irrespective of whether whichever resides and/or operates heretofore and hereafter anytime, anywhere and anyplace within, throughout and/or transcending whichever geographical territories of a single holistically econometric marketplace environment, wherefrom hereto collectively innate conception, terminological conveyance, indivisible rubric, syntactic oralformulaic, unique artwork, systematic arrangement, differentiated crafting, artistic construct, melodious lyrics, denominative literateness and thereat proprietary multiport revolving chambered binary hunting metallic track encasing hermetic lock up cast casing constrained unified real-time microprocessor machine language object block keyhole combinational software computer code heretofore and hereafter apprehends PUBLIC FINANCIALS™ organizations, proprietary trademark and service mark is exclusive proprietary intellectual property belonging exclusively and unequivocally to Juan Carlos Castro. Wherefrom every and all aforementioned PUBLIC FINANCIALS™ organizations are necessarily involved, effecting comprehensively suitable, generally pertinent and broadly useful individualize and/or combinatorial elements, components, factors, ingredients, constituents and/or integral associatives comprehensively suitable, generally pertient and broadly useful albeit somewhat limiting characterized as classifications, categorizations and/or stratifications entailing, encompassing, comprising, involving, impacting and/or effecting every and all, without limitation, natural, derivative and/or synthetic: agriculture; construction; foods; beverages; lumber; mining; natural resources; primary metals; textiles; fabrics; machinery; computing articles; computing devices, computing hardware, computing software; electronical conduits; transportation equipment; manufacturing instruments; railroad, train, transit, air, land and/or water transportation equipment; all communications; fuel, enery and power utilities; wholesale; retail; banking; finance; insurance; real estate; general services; non-classifiable; public administration; and/or national security functions, variables and/or functionalities entailing, encompassing, comprising, involving, impacting and/or effecting every and all, without limitation, governing, legal, accounting, financing, auditing, reporting, and/or exchange heretofore via so-called wide-spread, annoying, raptorial, voracious, unfruitful, unmerciful, boisterous, bolstering, unsubstantiated, unnecessary, unwarranted, unmitigated and unjustifiable marketing, advertising, promoting, propitiating, soliciting, associating and/or sponsoring via every and all inefficient, ineffective, disparate, dysfunctional, fragmented, antiquated, archaic, ancient history and superannuated initiatives schemes, ocurrences, happenings, interactions, processes, methods, practices, movements, proceedings, messaging, presentations, notifications, filings, submissions, records, activities, actions, events, endeavors, tasks and affairs, without limitation, comprehensively, generally and braodly entailing, encompassing, comprising, involving, impacting and/or effecting every and all, without limitaton, of the following: information; scooping; headlining; news; commercials; advertisements; silkiers; notices; intertwining; messaging; mailing; articles; fliers; circulars; letters; directing; twisting; proping; webpaging; researching; developing; convoluting; designing; uploading; posting; hosting; cooking; searching; downloading; dialoguing; streaming; spamming; slamming; cramming; churning; dumping; gouging; discounting; allowing; rebating; couponing; propagandizing; refunding; enticing; miring; returning; specializing; discounting; discoursing; conspiring; contriving; devising; conversing; prying; peeping; viewing; hacking; linking; mixing; releasing; pressing; updating; headlining; reportings; announcing; pronouncing; promoting; sponsoring; propitiating; soliciting, contracting; traces; editorials; newsletters; coiling; newspapers; periodicals; publications; magazines, wherefrom whichever and whenever hereafter naturally evincing and requisiting every and all, without limitation, conceived, created, engineered, designed, development, and hereto concretizing via consummate melioristic logical positivism devotional praxis and timely constructive reduction to practice UCMOST™ real-time processing and/or reprocessing. Wherefrom moreover hereto, without limitation, UCMOST™ real-time processing and/or reprocessing is logically comprehensively suitable, generally pertinent and broadly useful wherever entailing, encompassing, comprising, involving, impacting and/or effecting every and all private and/or public commercial, associational, town, locale, city, municipal, metropolis, district, province, state, federal, country, nation, transnational, multinational, transnational, federation and/or confederation governmental reasearch, development, planning, building, construction, startup, operations, management, upkeep and/or dissolving within aforementioned PUBLIC FINANCIALS™ organizations slumbery, suburbanized and/or high-society areas, people, places and/or things inclusive of, without limitation, every and all aforementioned PUBLIC FINANCIALS™ organizations transportation, living, dwelling, working, educational, playing, sporting, gaming, recreational, nutritional, entertainment, health, safety, prevention, policing, inspection, fitness, nutritional, rehabilitation, correctional, retirement and sight-seeing pleasure, business, public and/or instruction tour dwellings, buildings, facilities, complexes and constructs; wherefrom hereto undeniably, logically, scientifically and intuitively necessarily whichever requisite every and all integrated and integral traditional and/or alternative water and sewer, utility lighting and fueled energy power including, without limitation every and all necessary communicative utilities applicable to, without limitation, every and all aforementioned PUBLIC FINANCIALS™ organizations building and construction architectural design and structural engineering inclusive of, without limitation, every and all building and construction development and implementation of every and all of the following: public construction; public access waterway vehicular transports; high-way, aboveground and/or underground vehicular public access way transport substructure surface roadbed pavement research, engineering, developments and constructions; public access roadway upright orthorhombic rhombus traverse vehicular transport light-postings; public access roadway sideway orthorhombic rhombus traverse vehicular transport guard-railings; public access roadway surface orthorhombic rhombus traverse vehicular transport painting right of way directional directives signaling propagations; public access roadway curbside orthorhombic rhombus traverse vehicular transport painting right of way directional directives signaling propagations: public access roadway roadbed orthorhombic rhombus traverse vehicular transport surface pavement; public access roadway roadbed orthorhombic rhombus upright traverse vehicular transport directional directives locative signaling propagations; private and/or public spaces, sport and play parks, civic centers, arenas, sites, atriums, buildings, stadiums and/or arenas comprehensively suitable, generally pertinent and broadly useful to public service, theatrical, sporting, recreational, nutritional, entertainment, business and/or eductional purpose dwellings; private and/or public slumbery apartment building facilities and complex housing dwellings; private and/or public suburbanized resident town home dwellings; private and/or public midde-class suburbanized residential property home dwellings; high-society suburbanized residential property; private and/or public commercial workplace productivity suburbanized and downtown dwellings; private and/or public commercial products showplace dwellings; private and/or public commercial merchandising showplace dwellings; private and/or public commercial health, well-being, retirement, pharmaceutical and/or nutritional productivity dwellings; private and/or public commercial workplace productivity perpendiular upright traverse elevator dwellings; private and/or public commercial workplace productivity upright orthorhombic traverse walkway dwellings; private and/or public public service, theatrical, sporting, recreational, nutritional, health, rehabilitation, correctional, entertainment, business and/or eductional purpose dwellings; inclusive of private and/or public commercial foods, goods, products, supplies and/or services inclusive of every and all of the following: nutritional packaged goods, perishable vegetables, perishable poulty, perishalbe meats, perishable foods inclusive of every and all garmets, foods, beverages, packaged alcoholic beverages, packaged preferential cigarettes, packaged alcoholic wine and spritz, inclusive of, without limitation every and all other heretofore known and/or unknown, developed and/or undeveloped packaged cosmetics wherefrom hereto every and all necessarily requisite market research, development, planning, capitalizing, promoting, building, construction, startup, operations, management, upkeep and/or dissolving which potentially requisite every and all of the following: purchasing, construction, development, upkeep, operating, leasing and/or sales permits; purchasing, construction, development, upkeep, operating, leasing and/or sales licenses; purchasing, construction, development, upkeep, operating, leasing and/or sales assessments; purchasing, construction, development, upkeep, operating, leasing and/or sales rates; purcahse, operating and/or leasing fees purchasing, construction, development, upkeep, operating, leasing and/or sales chages; purchasing, construction, development, upkeep, operating, leasing and/or sales surcharges; purchasing, construction, development, upkeep, operating, ling and/or sales tariffs; purchasing, construction, development, upkeep, operating, leasing and/or sales costing, purchasing, construction, development, upkeep, operating, leasing and/or sales price listing; purchasing, construction, development, upkeep, operating, leasing and/or sales s ales pricing; purchasing, construction, development, upkeep, operating, leasing and/or sales coupon rebating; purchasing, construction, development, upkeep, operating, leasing and/ors sales coupon refunding; purchasing, construction, development, upkeep, operating, leasing and/or sales discounting; purchasing, construction, development, upkeep, operating, leasing and/or sales allowing; purchasing, construction, development, upkeep, operating, leasing and/or sales redemptions; purchasing, construction, development, upkeep, operating, leasing and/or sales taxes; purchasing, construction, development, upkeep, operating, leasing and/or sales power; purchasing, construction, development, upkeep, operating, leasing and/or sales energy; purchasing, construction, development, upkeep, operating, leasing and/or sales parts, purchasing, construction, development, upkeep, operating, leasing and/or sales accessories; purchasing, construction, development, upkeep, operating, leasing and/or sales fixtures; purchasing, construction, development, upkeep, operating, leasing and/or sales amenities; purchasing, construction, development, upkeep, operating, leasing and/or sales insurances; purchasing, construction, development, upkeep, operating, leasing and/or sales assurances; purchasing, construction, development, upkeep, operating, leasing and/or sales warranties; purchasing, construction, development, upkeep, operating, leasing and/or sales contractual arrangements; purchasing, construction, development, upkeep, operating, leasing and/or sales property assessments; purchasing, construction, development, upkeep, operating, leasing and/or sales blueprints, purchasing, construction, development, upkeep, operating, leasing and/or sales designs; purchasing, construction, development, upkeep, operating, leasing and/or sales workflow charts; purchasing, construction, development, upkeep, operating, leasing and/or sales security systems; purchasing , construction, development, upkeep, operating, leasing and/or sales property redemption assessements; purchasing, construction, development, upkeep, operating, leasing and/or sales property sub-leasing assignments; purchasing, construction, development, upkeep, operating, leasing and/or sales property sale assessments; wherefrom hereto whichever also necessarily potentially requite every and all musical, opera, play, drama, travesty, horror, tragedy, comedy, animation, action, porn, science-fiction and/or theatrical copious works of literary, theatrical, melodius, artistic, sporting, eductional, pleasure, recreational and entertainment audio, video, voice, visual, graphic and/or image compositions, productions, performances, solicitations, promotions, commercials, advertisements, promulgations and/or propagations potential entailing, encompassing, comprising, involving, impacting and/or effecting every and all of the following: transportation, living, working, educational, playing, sporting, recreational, nutritional, entertainment, health, safety, prevention, water and sewer, utilities, policing, inspection, fitness, rehabilitation, correctional, retirement and/or sightseeing tour dwelling, public access ways and/or public access way media potentially inclusive of every and all of the following: physical governance magistrate legal, regulatory, contractual, employment, civil, penal, punitive, statutory and/or criminal apprehensions, injuctions, suits, indictments, subpoena, writ, claims, declarations, depositions, discoveries, patents, proceeedings, grand juries, trials, mock trials, summary judgments, plea bargain settlements, currency settlements, arbitrations, mediations, damages, awards, adjudications, pardons and/or time-served adjustments; physical governance elective and/or appointed legislative, executive, sur-charges, inclusive of every and all sales taxes, income taxes, alternative minimum taxes, capital gains taxes, death rate taxes, estate rate taxes, probate rate taxes, marriage rate taxes, inclusive of import/export clearance inventory tariff and trade licenses, taxes, rates, assessments, charges, fees, tariffs, sur-charges, further inclusive of, without limitation, every and all whichever vehicle emission controls, police authorities, vehicle registrative controls, vehicle pool management, vehicle pool maintenance, general public copious works, general parks and recreations, general airport authorities, generald-port authorities, general sea-port authorities, housing and development, economic development, welfare services, child endangerment services, health and nutrional services, fire protection and inspective authorities, building code construction inspective authorities, police protection and inspective authorities, national defense and national security, general vehicle damage, loss and injury inspections, general vehicle roadway speed inspective authorities, general public water management, general public sewer maintenance, general public police housing construction, wherefrom hereto whichever requiting transactional exchange data collectively aforementioned PUBLIC FINANCIALS™ instruments inclusive of every and all necessarily integrated, critically important and increasingly integral associative and/or differential definite integrer denumerable metric system precise measurements from which every and all real-time processing and/or reprocessing of data and/or information receiver is comprehensively suitable, generally pertinent and broadly useful entailing, encompassing, comprising, involving, impacting and effect every and all necessarily derivative data retrieval and/or information retreieval inclusive of data reretrieval and/or information reretrieval accumulator generated aforementioned PUBLIC FINANCIALS™ statements. Wherefrom further hereto whichever actualizing a novel, unobvious, unknown, unforeseen, unprecedented, epoch, paper-less, ease of use, fruitful, opportune, never faltering and never failing panacean cutting-edge breakthrough utility engineering and groundbreaking technological architectural design innovation comprehensively suitable, generally pertinent and broadly useful to every and all aforementioned PUBLIC FINANCIALS™ instruments inclusive of every and all necessarily integrated, critically important and increasingly integral aforementioned PUBLIC FINANCIALS™ statements wherefrom hereto whichever private individuals, private and/or public commercial, labor respectively, independently, autonomously, evidently, undeniably, logically, scientifically and intuitively found to be inevitably necessary and increasingly integral member participants within a capital market of the holistically economic marketplace environment inclusive of, without limitation, every and all of the heretofore tens of hundreds of thousands inclusive of heretofore and herefater tens of hundreds of millions whichever principles, standards, interpretations, practices, theories, philosophies, disertating, counseling, advising, guiding, recommending, representing, courts, trials, appeals, council, forum, arbitration, mediation, diplomatics, summits, diplomacies, agreements, accords, partnerships, companies, firms, incorporations, mergers, treaties, treaty, session, consortium, bi-cameral committee, cabinet, commission, convention, declaration, doctrine, constitution, amendment, patent, congressional, legislature, executive and/or judicial jurisdictional transactional exchange initiatives, schemes, ocurrences, happenings, interactions, processes, methods, practices, movements, proceedings, messaging, presentations, notifications, filings, submissions, records, activities, actions, events, endeavors, tasks and affairs whichever irrespective of whether occuring, happening and/or transpiring residually and/or occuring, happening and/or transpiring spontaneously therein further every and all whose inherent aim, letter, nature, breadth, sound, depth, spirit and scope herewith invokes, without limitation, across-the-board traversal of every and all of the tens of hundreds of thousands of the aforementioned PUBLIC FINANCIALS™ organizations. Wherefrom every and all whichever heretofore and hereafter tens of hundreds of thousands of aforementioned PUBLIC FINANCIALS™ organizations respectively, independently, autonomously, evidently, undeniably, logically, scientifically and intuitively are hereto discovered to be inevitably necessary and increasingly integral living and breathing biological organisms within a capital market transmuting every and all multifaceted industries and multidimensional sectors of the industrialized, developed and developing free-market commerce and trade blocs within, throughout and transcending every and all whicever geographical territories of a single holistically econometric marketplace environment, wherefrom hereto every and all are hereby necessarily concretizing as streamlined, alternating scale, inseparable, seamless and naturally wrapped, twisted, convoluted, coupled and combined heretofore and hereafter as combinatorial with immature child students; so-called immature adolescents; so-called immature adolescence students; so-called mature adults; so-called academic students; so-called independent writers; so-called independent bibliographers, so-called independent photographers, so-called independent editorial investigators; so-called independent editors; so-called independent reporters; so-called independent publishers; so-called independent printmakers; so-called independent advertisers; so-called independent marketers; so-called independent manufacturers; so-called independent farmers; so-called independent owners; so-called independent labor personnel; so-called independent distributors; so-called independent resellers; so-called independent composers; so-called independent developers; so-called independent producers; so-called independent artists; so-called independent preachers; so-called independent philosophers; so-called independent inventors; so-called appointed managers; so-called elected mayors; so-called elected commissioners; so-called elected state congress representatives; so-called elected state congress senators; so-called elected state governors; so-called elected national congress representatives; so-called elected national congress senators; so-called elected national presidents; so-called elected jurisprudential district judges; so-called appointed jurisprudential state judges; so-called appointed jurisprudential circuit judges; so-called appointed jurisprudential national judges; so-called appointed national jurisprudential generals; so-called elected state jurisprudential generals; so-called appointed national civil service commissioners; so-called appointed national civil service representatives; so-called elected state civil service commissioners; so-called appointed state civil service representatives; so-called appointed polity party bureaucratic officials; so-called civil service bureaucratic representatives; so-called civil service bureaucratic managers; so-called civil service correctional labor personnel; so-called civil service correctional representatives; so-called civil service correctional officials; so-called elected civil service jurisprudential investigative officials; so-called civil service commissioned jurisprudential investigative officers; so-called civil service commissioned jurisprudential investigative assistants; so-called independent commercial private correctional officers; so-called commercial private service investigators; so-called civil service rehabilitation representatives; so-called civil service rehabilitation managers; so-called civil service called appointed civil service administrative wardens; so-called appointed commercial administrative wardens; so-called civil service labor personnel; so-called drafted military armed services labor personnel; so-called enlisted military armed services labor personnel; so-called enlisted military armed services non-commissioned personnel; so-called enlisted military armed services non-commissioned personnel correctional officers; so-called enlisted military armed services non-commissioned correctional wardens; so-called enlisted military armed services non-commissioned personnel rehabilitation officers; so-called enlisted military armed services non-commissioned personnel rehabilitation wardens; so-called enlisted military armed services non-commissioned rehabilitation pharmacologists; so-called enlisted military armed services non-commissioned medical physician doctors, so-called enlisted military armed services non-commissioned sergeants; so-called enlisted military armed services non-commissioned staff sergeants; so-called enlisted military armed services non-commissioned master staff sergeants; so-called military armed services commissioned lieutenant officers; so-called military armed services commissioned lieutenant commanders; so-called military armed services commissioned captain officers; so-called military armed services commissioned major officers, so-called military armed services commissioned lieutenant colonel officers; so-called military armed services commissioned colonel officers; so-called military armed services commissioned field-grade officers; so-called military armed services commissioned brigadier general officers, so-called military armed services Uniform Code of Military Justice (UCMJ); so-called military armed services commissioned jurisprudential investigators; so-called military armed services commissoned jurisprudential practicioners; so-called military armed services commissioned jurisprudential jurists; so-called acknowledged assistant teachers; so-called certified teachers; so-called acknowledged associate professors; so-called tenured professors; so-called tenured jurisprudential scholars; so-called licensed jurisprudential practitioners; so-called tenured medical physician scholars; so-called licensed medical physician doctors; so-called accounting professor scholars; so-called certified accounting practitioners; so-called auditing professor scholars; so-called certified auditing practitioners; so-called commercial business professor scholars; so-called commercial business practitioners; so-licensed medical physician pschiatrists; so-called acknowledged associate pharmacists; so-called licensed pharmacologists; so-called unordained clericalists; so-called ordained clericalists; so-called politicking party members; so-called society inductees; so-called chamber representatives; so-called convention members; so-called summit participants; so-called commercial service labor personnel; so-called consumers; so-called member-subscribers; so-called customers; so-called clients; so-called constituents; so-called debtors; so-called creditors; so-called shareholders; so-called stakeholders; so-called U.S. depositors; so-called U. S. citizen taxpayers; so-called foreign national depositors; so-called foreign national taxpayers; so-called princeship; so-called princesses; so-called dukes; so-called dukesses; so-called ambassadors; so-called diplomats; so-called monarchs; so-called global depositors; so-called domestic citizenry; so-called foreign citizenry; so-called domestic retiree citizenry; so-called foreign retiree citizenry; so-called general populace; wherefrom every and all, without limitation, of whom are also respectively, independently, autonomously, evidently, undeniably, logically, scientifically and intuitively found to be inevitably necessary and increasingly integral living and breathing biological organisms within a capital market, heretofore and hereafter irrespective of whether whichever resides and/or operates heretofore and hereafter anytime, anywhere and anyplace within, throughout and/or transcending whichever geographical territories of a single holistically econometric marketplace environment, wherefrom moreover every and all whose inherent aim, letter, nature, breadth, sound, depth, spirit and scope herewith invokes, without limitation, across-the-board traversal of every and all of the hundreds of millions undeniably, evidentiary, logically, scientifically, intutively and necessarily depositors inclusive of undeniably, evidentiary, logically, scientifically, intutively and necessarily investors involving holding and/or fixtured in aim, letter, nature, spirit, scope, breadth and depth: so-called proprietary; so-called partnership; so-called company; so-called firm; so-called corporation; so-called incorporation; so-called commercial; so-called franchise; so-called union; so-called thrift; so-called group; so-called board; so-called institute; so-called convention; so-called bi-cameral; so-called society; so-called chamber; so-called convention; so-called summit; so-called not-for-profit; so-called foundation; so-called endowment; so-called association; so-called town; so-called locale; so-called city; so-called municipal; so-called metropolis; so-called county; so-called district; so-called province; so-called state; so-called federal; so-called country; so-called nation; so-called transnational; so-called multinational; so-called transnational; so-called federation; so-called confederation; whichever private individuals, private and/or public commercial, labor unionized, religious sect, political ideological, group associational and/or public governance legal and/or status of existence above and below mentioned are undeniably, evidentiary, logically, scientifically and intuitively members of a universal citizenry, every and all of whom further, without limitation, are respectively, independently, autonomously, evidently, undeniably, logically, scientifically and intuitively found to be inevitably necessary and increasingly integral members of a capital market, heretofore and hereafter irrespective of whether whichever resides and/or operates anytime, anywhere and anyplace within, throughout and/or transcending whichever geographical territories of a single holistically econometric marketplace environment, wherefrom hereto innate conception, terminological conveyance, indivisible rubric, syntactic oralformulaic, unique artwork, systematic arrangement, differentiated crafting, artistic construct, melodious lyrics, denominative literateness and thereat proprietary multiport revolving chambered binary hunting metallic track encasing hermetic lock up cast casing constrained unified real-time microprocessor machine language object block keyhole combinational software computer code heretofore and hereafter apprehends UNIVESAL POPULACE™, proprietary trademark and service mark is exclusive proprietary intellectual property belonging exclusively and unequivocally to Juan Carlos Castro. Wherefrom terminological denominate syntactic synthesis invoking aforementioned UCMOST™ information technology is comprehensively suitable, generally pertinent and broadly useful to every and all, without limitation, aforementioned PUBLIC FINANCIALS instruments hereto harnessed, wrapped, leveraged and unequivocally apprehended in connection with every and all, without limitation, of the aforementioned PUBLIC FINANCIALS™ statements from every and all individual members of the aforementioned UNIVERSAL POPULACET™ which are heretofore and hereafter undeniably, logically, scientifically and intuitively comprehensively suitable, generally pertient and broadly useful to every and all real-time processing and/or balance accounts of every and all private individuals inclusive, without limitation, of every and all public organizations within, throughout and transcending the national sovereign so-called borders of every and all of the industrialized, developed and developing free-market commerce and trade bloc economies within a single holistically econometric marketplace environment; wherefrom whichever further entailing, encompassing, comprising, involving, impacting and/or effecting every and all legal interstate and/or intrastrate Uniform Commercial Code (UCC), inclusive of legal transnational and/or transnational commercial mercantile free-trade agreements transcending national sovereign so-called borders of trade block economies, inclusive of, without limitation, every and all utility and design innovation stemming from effortless reseach development and technological advancement whereby mitigating every and all polarizing situations and/or unnecessary concerns involving the Anti-Ballistic Misssle Treaty; the North American Free Trade Agreement (NAFTA); the European Economic Union (EEU); the Asian-Pacific Economic Community (APEC); wherefrom aforementioned PUBLIC FINANCIALS™ statements from every and all individual members of the aforementioned UNIVERSAL POPULACE™ which are heretofore and hereafter undeniably, logically, scientifically and intuitively comprehensively suitable, generally pertient and broadly useful to every and all real-time processing and/or reprocessing of data and/or information receiver entailing, encompassing, comprising, involving, impacting and/or effecting every and all ledger trace account, trial balance, cash flow, profit and loss and/or balance sheet; wherefrom whichever inherently, intrinsically, clearly, undeniably, logically, scientifically and intutively deriving and/or driving every and all personal financial statement inclusive of, without limitation, every and all public statement of revenue, cost of goods sold, depreciation expenditure, other operational expenditure, interest expenditure if applicable, taxes payable and/or deferred taxes payable, and residual profit if available, public statement of financial position or so-called public balance sheet, and public statement of cash flows inherently derived from every and all cash inflow and/or outflow from ledger account receivables, ledger account payables, acquisitions of property, plant, boiler and machinery equipment, ledger account short-term borrowing, ledger account long-term borrowing, new residual equity issuance and potential payment of dividends which occur, and all distinctively separate and traditionally exclusive private and/or public off-balance sheet statement of financial position whichever owned as majority and/or minority participations, wherefrom further hereto every and all of which entail, encompass, comprise, involve, effect and impact every and all current and long-term ledger account asset receivable balances, ledger account asset Universal Character Set (UCS) and/or Universal Decimal System (UDS) driven and/or effectuated Universal Product Code (UPC) inventory balances, ledger account asset or potentially liability balances, ledger account other long-term asset balances, ledger account liability payable balances, ledger account interest liability payable balances, ledger account other long-term liability payable balances, ledger account additional paid-in capital residual equity balances, ledger account structural capitalization residual equity balances, and other ledger account alternative structural capitalization residual equity balances, wherefrom further hereto every and all entail, encompass, comprise, involve, effect and impact every and all assets, liabilities and/or residual equities from private and/or public sub-unit, unit, divisional, segmented and/or consolidated elements, components, factors, constituents and ingredients comprising aforementioned PUBLIC FINANCIALS™ statements which inherently involve multifaceted and multidimensional non-financial account headings and non-financal contra-account headings entailing, encompassing, comprising, involving, impacting and/or effecting intrinsically and inherently, without limitation, every and all real-time processing and/or reprocessing of data and/or information receiver from every and all general populace, elected officials, appointed dignitaries, appointed diplomats, public/private organizations, sovereign government entities and/or not-for-profit organizations all of whom are respectively, independently, autonomously, evidently, undeniably, logically, scientifically and intuitively found to be inevitably necessary and increasingly integral member participants within a single holistically econometric marketplace environment. It is clearly an undeniable and evidentiary findings of fact, documented reference, logical scientific deduction and intuitive analytical reasoning that whichever respective aforementioned PUBLIC FINANCIALS™ instruments inclusive of necessarily integrated, critically important and increasingly integral aforementioned PUBLIC FINANCIALS™ statements from members of the aforementioned UNIVERSAL POPULACE™ whichever increasingly integral entities, beings, elements, components, factors, constituents and ingredients within members of the aforementioned UNIVERSAL POPULACE™ for which apprehending and concretizing an innovative unequivocal absolute resolution solution invoked within aforementioned UCMOST™ information technology; which are herewith evinced as instrinsically, integrally and comprehensively suitable, generally pertinent and broadly useful to streamlining and integrating every and all ideas, matters, issues, events, movements, calendrical, dialogues, discourses, occurences, transpiring, happening, happenstance, discovering, concepts, principles, standards, interpretations, practices, theories, philosophies, disertating, counseling, advising, guiding, recommending, representing, courts, trials, appeals, council, forum, arbitration, mediation, diplomatics, summits, diplomacies, agreements, accords, members of the aforementioned UNIVERSAL POPULACP™ legal reapportionment definitive discrete integer numeric metric system figure tabulating elective propagations; wherefrom furthermore, hereto members of the aforementioned UNIVERSAL POPULACE™ legal appropriation definitive discrete integer numeric metric system figure tabulating elective propagations; wherefrom moreover hereto members of the aforementioned UNIVERSAL POPULACE™ legal emergency planning definitive discrete integer numeric metric system figure tabulating emergency standy workforce elective propagations; wherefrom furthermore hereto members of the aforementioned UNIVERSAL POPULACE™ legal emergency planning definitive discrete integer numeric metric system figure tabulating natural disaster fund elective propagations; wherefrom moreover hereto members of the aforementioned UNIVERSAL POPULACE™ legal emergency planning definitive discrete integer numeric metric system figure tabulating disaster relief elective propagations; wherefrom furthermore hereto members of the aforementioned UNIVERSAL POPULACE™ legal emergency planning definitive discrete integer numeric metric system figure tabulating insurance fund elective propagations; wherefrom moreover hereto members of the aforementioned UNIVERSAL POPULACE™ legal emergency planning definitive discrete integer numeric metric system figure tabulating insurance relief elective propagations; wherefrom furthermore hereto members of the aforementioned UNIVERSAL POPULACE™ legal emergency planning definitive discrete integer numeric metric system definitive discrete integer numeric metric system figure tabulating assurance relief elective propagations; wherefrom furthermore hereto members of the aforementioned UNIVERSAL POPULACE™ legal retirement planning definitive discrete integer numeric metric system figure tabulating social entitlement fund elective propagations; wherefrom moreover hereto members of the aforementioned UNIVERSAL POPULACE™ legal retirement planning definitive discrete integer numeric metric system figure tabulating social entitlement security relief elective propagations; wherefrom furthermore hereto members of the aforementioned UNIVERSAL POPULACE™ legal domestic and/or expatriate dominion certified domain passport recording definitive discrete integer numeric metric system figure tabulating elective propagations; wherefrom moreover hereto members of the aforementioned UNIVERSAL POPULACE™ legal migratory census tracking definitive discrete integer numeric metric system figure tabulating elective propagations; wherefrom furthermore hereto members of the aforementioned UNIVERSAL POPULACE™ legal daily, weekly, semi-monthly, monthly, semi-annual, trimester, annual, seasonal, cyclical, frictional and/or fractional employment tracking definitive discrete integer numeric metric system figure tabulating elective propagations; wherefrom moreover hereto members of the aforementioned UNIVERSAL POPULACE™ legal voter registration definitive discrete integer numeric metric system figure tabulating elective propagations; wherefrom furthermore hereto members of the aforementioned UNIVERSAL POPULACE™ legal voting ballot casting definitive discrete integer numeric metric system figure tabulating elective propagations; wherefrom furthermore hereto members of the aforementioned UNIVERSAL POPULACE™ legal voter reregistration definitive discrete integer numeric metric system figure tabulating elective propagations; wherefrom moreover hereto members of the aforementioned UNIVERSAL POPULACE™ legal voting ballot definitive discrete integer numeric metric system figure tabulating elective propagations; wherefrom moreover hereto members of the aforementioned UNIVERSAL POPULACE™ legal absentee voting ballot definitive discrete integer numeric metric system figure tabulating elective propagations; wherefrom moreover hereto members of the aforementioned UNIVERSAL POPULACE™ legal proxy voting ballot definitive discrete integer numeric metric system figure tabulating elective propagations; tabulating disaster protection elective propagations, wherefrom moreover hereto members of the aforementioned UNIVERSAL POPULACE™ legal occupancy protection definitive discrete integer numeric metric system figure tabulating disaster relief elective propagations; wherefrom furthermore hereto members of the aforementioned UNIVERSAL POPULACE™ legal motor vehicle licensing definitive discrete integer numeric metric system figure tabulating elective propagations; wherefrom moreover hereto members of the aforementioned UNIVERSAL POPULACE™ legal motor vehicle relicensing definitive discrete integer numeric metric system figure tabulating elective propagations; wherefrom furthermore hereto members of the aforementioned UNIVERSAL POPULACE™ legal motor vehicle reregistration definitive discrete integer numeric metric system figure tabulating elective propagations; wherefrom moreover hereto members of the aforementioned UNIVERSAL POPULACE™ legal motor vehicle insurance protection definitive discrete integer numeric metric system figure tabulating elective propagations; wherefrom furthermore hereto members of the aforementioned UNIVERSAL POPULACE™ legal motor vehicle reassurance protection definitive discrete integer numeric metric system figure tabulating elective propagations; wherefrom moroever hereto members of the aforementioned UNIVERSAL POPULACE™ legal motor vehicle emission inspection definitive discrete integer numeric metric system figure tabulating elective propagations; wherefrom furthermore hereto members of the aforementioned UNIVERSAL POPULACE™ legal motor vehicle emission reinspection definitive discrete integer numeric metric system figure tabulating elective propagations; wherefrom moreover hereto members of the aforementioned UNIVERSAL POPULACE™ legal motor vehicle assurance protection definitive discrete integer numeric metric system figure tabulating elective propagations; wherefrom furthermore hereto members of the aforementioned UNIVERSAL POPULACE™ legal motor vehicle reassurance protection definitive discrete integer numeric metric system figure tabulating elective propagations; wherefrom moreover hereto members of the aforementioned UNIVERSAL POPULACE™ legal motor article assurance protection definitive discrete integer numeric metric system figure tabulating elective propagations; wherefrom furthermore hereto members of the aforementioned UNIVERSAL POPULACE™ legal motor article reassurance protection legal procedural recording definitive discrete integer numeric metric system figure tabulating elective propagations; wherefrom furthermore hereto members of the aforementioned UNIVERSAL POPULACE™ legal civil recording definitive discrete integer numeric metric system figure tabulating elective propagations; wherefrom moreover hereto members of the aforementioned UNIVERSAL POPULACE™ legal real-estate zoning definitive discrete integer numeric metric system figure tabulating elective propagations; wherefrom furthermore hereto members of the aforementioned UNIVMRSAL POPULACE™ legal background criminal recording definitive discrete integer numeric metric system figure tabulating elective propagations; wherefrom moreover hereto members of the aforementioned UNIVERSAL POPULACE™ legal public recording definitive discrete integer numeric metric system figure tabulating elective propagations; wherefrom furthermore hereto members of the aforementioned UNIVERSAL POPULACE™ legal bankruptcy seizure, disolvement, distribution and/or transport recording definitive discrete integer numeric metric system figure tabulating elective propagations; wherefrom moreover hereto members of the aforementioned UNIVERSAL POPULACE™ legal credit reporting definitive discrete integer numeric metric system figure tabulating elective propagations; wherefrom furthermore hereto members of the aforementioned UNIVERSAL POPULACE™ legal background check reporting definitive discrete integer numeric metric system figure tabulating elective propagations; wherefrom moreover hereto members of the aforementioned UNIVERSAL POPULACE™ legal disertating, counseling, advising, guiding, recommending, representing, courts, trials, appeals, arbitrations, mediations, council, forum, diplomatics, summits, diplomacies, agreements, accord, partnership, alliance, joint venture, incorporations, mergers, treaties, treaty, session, consortium, bi-cameral, committee, cabinet, commission, convention, declaration, doctrine, constitution, amendment, patent, congressional, legislature, executive and/or judicial recording definitive discrete integer numeric metric system figure tabulating elective propagations; wherefrom furthermore hereto members of the aforementioned UNIVERSAL POPULACE™ legal appropriation recording definitive discrete integer numeric metric system figure tabulating elective propagations, wherefrom moreover hereto personal, members of the aforementioned hereto members of the aforementioned UNIVERSAL POPULACE™ legal retrenchment recording definitive discrete integer numeric metric system figure elective propagations; wherefrom moreover hereto members of the aforementioned UNIVERSAL POPULACE™ legal asset seizure, clearance, conversion, assignment, distribution and/or transport recording definitive discrete integer numeric metric system figure elective propagations; wherefrom furthermore hereto members of the aforementioned UNIVERSAL POPULACE™ legal residual equity seizure, clearance, conversion, assignment, distribution and/or transport recording definitive discrete integer numeric metric system figure elective propagations; and wherefrom moreover hereto members of the aforementioned UNIVERSAL POPULACE™ legal liability seizure, clearance, conversion, assignment, distribution and/or transport recording definitive discrete integer numeric metric system figure elective propagations. Wherefrom every and all aforementioned inherently entail, encompass, comprise, involve, impact and/or effect every and all obscurant, irresponsible, feculent, irrational, feckless, disrespectful, mendacious, ignorant, malicious, condescending, untruthful, insolent, inefficient, incognizant, ineffective, fragmenting, unlettered, unpolished, presumptuous, portentous, pretentious, fruitless, disparate, antiquated, archaic, ancient history and superannuated so-called real-time processing and/or reprocessing of data and/or information receiver inclusive of, without limitation, every and all filing of periodic, interim and annual Personal Financial Statements (PFS) inclusive of certified payments on income, capital gains and every and all comprehensively suitably, generally pertient and broadly useful herewith undeniably, logically, scientifically and intuitively necessarily integrated, critically important and increasing integral hereto members of the aforementioned UNIVERSAL POPULACE™ legal licenses, taxes, rates, assessments, charges, fees, tariffs, sur-charges inclusive of every and all pricing, costing, operating, franchising, leasing, purchasing, financing and/or commissioning proposed, stipulated, substantiated, justified, verified, traversed, enacted, levied, imposed, rated, assessed, certified, propagating and subsequent promulgation respectively via legitimate and instrinsically certified hereto members of the aforementioned UNIVERSAL POPULACE™ legal instrinsic and integral entities, beings, elements, components, factors, constituents and ingredients within, throughout and untruthful, insolent, inefficient, incognizant, ineffective, fragmenting, unlettered, unpolished, presumptuous, portentous, pretentious, fruitless, disparate, antiquated, archaic, ancient history and superannuated so-called U.S. Department of Treasury (so-called U.S. Treasury) superannuated internal revenue service agency generator scheduled and/or unscheduled Forms and Schedules inclusive of so-called U.S. Treasury Form 1040 in connection with applicable unitemized and basic so-called U.S. Treasury Schedule A, B, and D and/or so-called U.S. Treasury Form 1040-EZ from members of the aforementioned UNIVERSAL POPULACE™, inclusive of the more itemized and complex so-called U.S. Treasury Form 1040 in connection with a so-called U.S. Treasury Schedule C, wherefrom further hereto invoked within aforementioned UCMOST™ information technology is comprehensively suitable, generally pertinent and broadly useful to intrinsically certified filing every and all interim so-called U.K. Securities and Exchange Commission (so-called U.S. SEC) processing heretofore via the anciet history presently licensed Electronic Data Gathering and Automated Retrieval (EDGAR) System wherefrom hereto evincing interim so-called U.S. Form 8-K with a standard fifteen-day time-lagged inabsentia, hardship, inanition, skidding, stalling, hesitant, holding, refusing and restraining unscheduled aforementioned PUBLIC FINANCIALS™ statements, interim so-called U.S. SEC Form 10-Q with a standard forty-five time-lagged inabsentia, hardship, inanition, skidding, stalling, hesitant, holding, refusing and restraining aforementioned PUBLIC FINANCIALS™ statements, interim General Purpose Financial Statements (GPFS) aforementioned PUBLIC FINANCIALS™ statements, interim so-called U.S. SEC Form 10-QSB aforementioned PUBLIC FINANCIALS™ statements from small business registrants, interim so-called U.S. SEC Form SC-13G aforementioned PUBLIC FINANCIALS™ statements filings from beneficial owners, interim so-called U.S. SEC Form SC-13G/A aforementioned PUBLIC FINANCIALS™ statements amended filings from beneficial owners, interim so-called U.S. SEC Form DEF 13-F aforementioned PUBLIC FINANCIALS™ statements comprehensively suitable, generally pertinent and broadly useful to reporting on aforementioned PUBLIC FINANCIALS™ instruments from banking, securities, insurance related public organizations inlcusive of, without limitation, whichever furthermore transactional exchange advisers, transactional exchange companies, POPULACE™, interim so-called U.S. SEC Form DEF 14-A aforementioned PUBLIC FINANCIALS™ statements comprehensively suitable, generally pertinent and broadly useful to proxy voting from members of the aforementioned UNIVERSAL POPULACET™, interim so-called U.S. SEC Form 497 aforementioned PUBLIC FINANCIALS™ statements comprehensively suitable, generally pertinent and broadly useful to initial filing registration prospectus from transactional exchange company related members of the aforementioned UNIVERSAL POPULACE™, interim so-called U.S. SEC Form 24F-2NT aforementioned PUBLIC FINANCIALS™ statements of registration aforementioned PUBLIC FINANCIALS™ instruments from transactional exchange company related members of the aforementioned UNIVERSAL POPULACE™, interim so-called U.S. SEC Form N-30D aforementioned PUBLIC FINANCIALS™ statements comprehensively suitable, generally pertinent and broadly useful to semi-annual reporting from transactional exchange company related members of the aforementioned UNIVERSAL POPULACE™, initial so-called U.S. SEC Form 3 aforementioned PUBLIC FINANCIALS™ statements comprehensively suitable, generally pertinent and broadly useful to initial filing of directors, officers and persons or public organizations owning more than 10% of any class from members of the aforementioned UNIVERSAL POPULACE™, interim so-called U.S. SEC Form 4 aforementioned PUBLIC FINANCIALS™ statements comprehensively suitable, generally pertinent and broadly useful to filing intention of disolvement of positions from directors, officers and persons and/or public organizations owning more than 10% aforementioned PUBLIC FINANCIALS™ instruments of any class from members of the aforementioned UNIVERSAL POPULACE™, wherefrom further hereto annual so-called U.S. SEC Form 10-K with a standard ninety-day time-lagged inabsentia, hardship, inanition, skidding, stalling, hesitant, holding, refusing and restraining aforementioned PUBLIC FINANCIALS™ statements, annual Comprehensive Annual Financial Reports (CAFR) aforementioned PUBLIC FINANCIALS™ statements, annual so-called U.S. SEC Form 20-F aforementioned PUBLIC FINANCIALS™ statements and/or annual so-called U.S. SEC Form 5 aforementioned PUBLIC FINANCIALS™ statements respectively from domestic, foreign registrants and/or directors, officers and persons and/or public organizations owning more than 10% aforementioned PUBLIC FINANCIALS™ instruments to effectuate management decisions regarding the operating performance, transactional exchange and financial profitability members of the aforementioned UNIVERSAL POPULACE™, wherefrom hereto evidently deriving, inducing and invoking further terminological denominative of every and all aforementioned PUBLIC FINANCIALS™ instruments as comprehensively suitable, generally pertinent and broadly useful via streamlined, alternating scale, inseparable, seamless and natural wrapping, interlacing, coiling, coupling, combining and interlocking within every and all aforementioned PUBLIC FINANCIALS™ statements traversing inclusive of, without limitation, every and all other industries and sectors in a single holistically econometric marketplace environment beyond the following specified multifaceted industries and multidimensional sectors entailing, encompassing, comprising, involving, impacting and/or effecting banking, securities and insurance, wherefrom hereto it is clearly an undeniable and evidentiary findings of fact, documented reference, logical scientific deduction and intuitive analytical reasoning that every and all interim and so-called periodic aforementioned PUBLIC FINANCIALS™ statements from every and all members of the aforementioned UNIVERSAL POPULACE™ hereafter sporadically and randomly independently audited for the benefit of establishing an effective, functional and interlocking aforementioned efficient UNIVERSAL CAPITAL MARKET™, wherefrom further hereto invoking aforementioned UCMOST™ information technology is comprehensively suitable, generally pertinent and broadly useful as it entails, encompases, comprises, involves, impacts and effects knowledge of techniques, processes, aspects, topics, issues, matters, elements, components, functions, procedures, designs, systems, devices, forms, factors, ways, parts, segments and methods of combining aforementioned via originating automatizing real-time transmission propagating transporting transmuting partible beta particle beam gliding transponder converting receiver conduit aforementioned UCMOST™ real-time processing and/or reprocessing of data and/or information transmission whichever whenever wherefrom entailing, encompassing, comprising, involving, impacting and/or effecting every and all manufacture, formatting, production and distribution wherefrom whichever every and all aforementioned PUBLIC FINANCIALS™ instruments in connection with every and all aforementioned PUBLIC ocurrences, happenings, interactions, processes, methods, practices, movements, proceedings, messaging, presentations, notifications, filings, submissions, records, activities, actions, events, endeavors, tasks and affairs whether effectuated, without limitation, within, throughout and transcending every and all stock, bond, option, future, forward, swap, commodity, originating, derivative and/or synthetic derivative oriented antiquated, archaic, ancient history and superannuated heretofore licensed and/or non-certified market exchanges anytime, anyplace and anywhere within a single holistically econometric marketplace environment of which every and all necessarily, undeniably, logically, scientifically and intuitively entails, encompasses, comprises, involves, impacts and effects every and all whichever of the distincitvely separate and traditionally exclusive specialty areas of general private and public accounting, general private and public transport reconciling, general private and public independent auditing and general private and public reporting inclusive of every and all quotation, matching, clearance, settlement and exchange of general private and public insurance, general private and public so-called risk financing, general private and public credit, general private and public cash management, general private and public investment banking and general private and public aforementioned PUBLIC FINANCIALS™ instruments heretofore entailing, encompassing, comprising, involving, impacting and/or effecting every and all classifications, categorizations and/or stratifications of hereto members of the aforementioned UNIVERSAL POPULACE™ legal operations irrespective of whether whichever heretofore distinctively separate and traditionally exclusive aforementioned PUBLIC FINANCIALS™ instruments and whichever heretofore distinctively separate and traditionally exclusive aforementioned PUBLIC FINANCIALS™ statements are transpired and/or effectuated via every and all antiquated, archaic, ancient history and superannuated identifying, organizating, indexing, cataloging, categorizing and/or processing to inefficiently derive collections of literary, melodius, aesthetic and artistic works via audio, video, voice, visual and imaging media entailing, encompassing, comprising, involving, impacting and/or effecting, without limitation, every and all antiquated, archaic, ancient history and superannuated market exchanges residing and/or operating within every and all national sovereign borders of every and all of the industrialized, developed and developing every and all of the following mental, audio, visual, taste, touch and smell oriented apprehending and cognizably appearing, recognizing, identifying, acknowledging, associating, filtering, sorting, organizing, conceptualizing, understanding and comprehending representational abstract conceptual aids inclusive of, without limitation, every and all: word; character; denumerable; cast, label; category; acronym; trace; notice; letter; mailer; update; release; propaganda; newsletter; hard-cover book; soft-cover paper-back book; magazine; article; publication; periodical; magazine; serial; journals; editorial; newspaper; flier; card; circular; symbol; theme; directive; leaf-letter book; text-book; hypothesis; theory; manuscript; disertation; pamphlet; memorandum, promotion; silkier; announcement; pronouncement; prop; propitious; propel; solicit; advance; tempt; beckon; brochure; report; list; title; art; lyrics; songs; description; methodical; content; material; documentation; compilation; illustration; classification; catalog; manual; non-book; movie; video game; program; performances; enumeration; story; annotate; pictorial; photograph; print; paint; ink; oil; pastel; pigment; pen; pencil; dye; chalk; chart; graph; presentation; graphic; imaging; figuration; object; prop; antique; woodwork; craftwork; artwork; artifacts; array; audio; visual; voice; text; numerical; keying; pulsing; auctioning; laser; morse code; continental code; brailling; dialogue; discourse; literature; theatrical; represent; narrate; trace; reportage; play script; playbill; play write; comment; partial; heuristic; inference; exposition; announce; monologue; epilogue; speech; commentary; nominative; numeration; digits; charactery; denumerable; charade; characterization; reference; numeric; numismatic; fiction; nuptial; non-fiction; prose; allegory; anagram; black board; drawing board; computer aided designing; clip board; story board; back board; background; time exposure; tincture; tinging; distinguishing; tinsel; tinting; tinkling; tangible property; service mark; trademark; symbol; emblem; logo; flag; great seal; copyright; intangibles; proof; galley proof; press; copy; post; display; duplication; utilization; echo; reverberation; plea; mendicant; response; report; common talk; message; rumor; static; gossip; summation; relate; feature; presentation; append; fixture; etch; mount; embed; repugn; repulse; reprove; reprimand whether concretizing, actualized, materialized and/or traversed manually, artistically, theatrically, initiatives, schemes, ocurrences, happenings, interactions, processes, methods, practices, movements, proceedings, messaging, presentations, notifications, filings, submissions, records, activities, actions, events, endeavors, tasks and affairs hereto anywhere, anyplace and anytime via every and all standalone, networked, portable, desktop, laptop, tablet, transmit article, and/or fixtured compressible, compact and/or disparate electrial, battery, radio, television, telephony, telegraphy, typography, photographic and/or solar conduit read and write and/or write-only artifical atmospheric ground wave and/or aeronautical airway casing dish, transmitter, receiver, cassettee, cartridge, pan and/or container inclusive of, without limitation, all the following; microdisk; microfilm; microfiche; microplate; magnetic film; magnetic reel; hard diskette; floppy diskette; magnetic tape drive; magnetic film diskette; magnetic microfilm disk; magnetic microplate disk; paper tape cast; file folder; file drawer; file cabinet, display calculator; cash register; display cash register; display computing article; file storage computing article; teletype interface computing article; teleprompt interface computing article; articled hard core computing disk drive; articled mainframe computing disk drive; articled server computing disk drive; articled network transport routing computing disk drive; articled magnetic reel computing disk drive; articled personal hard computing disk drive; articled desktop hard computing disk drive; articled personal laptop computing disk drive; articled personal tablet computing disk drive; articled personal telephony computing disk drive; articled video game computing disk; articled digital video computing disk; wherefrom whichsoever, every and all whenever and wheresoever entailing, encompassing, comprising, involving, impacting and/or effecting manual, passive and/or below specified automatizing real-time transmission propagating transporting transmuting partible beta particle beam gliding transponder converting receiver conduit real-time processing and/or reprocessing of data and/or information of whichever whenever and whereever entailing, encompassing, comprising, involving, impacting and/or effecting manual, passive and/or automatizing real-time transmission propagating transporting transmuting partible beta particle beam gliding transponder converting receiver conduit aforementioned UCMOST™ real-time processing and/or reprocessing; wherefrom applicable herewith further entailing, encompassing, comprising, involving, impacting and/or effecting reasearch, development, pertient and broadly useful albeit extremely limited area classifictions and/or categorizations inclusive of, without limitation, every and all of the following; members of the aforementioned UNIVERSAL POPULACE™ agriculture; members of the aforementioned UNIVERSAL POPULACE™ construction; food members of the aforementioned UNIVERSAL POPULACE™ foods; members of the aforementioned UNIVERSAL POPULACE™ beverages; members of the aforementioned UNIVERSAL POPULACE™ lumber; members of the aforementioned UNIVERSAL POPULACE™ mining; members of the aforementioned UNIVERSAL POPULACE™ natural resources; members of the aforementioned UNIVERSAL POPULACE™ textiles; members of the aforementioned UNIVERSAL POPULACE™ primary metals; members of the aforementioned UNIVERSAL POPULACE™ fabrics; members of the aforementioned UNIVERSAL POPULACE™ machinery; members of the aforementioned UNIVERSAL POPULACE™ computing; members of the aforementioned UNIVERSAL POPULACE™ devices; members of the aforementioned UNIVERSAL POPULACE™ electronics; members of the aforementioned UNIVERSAL POPULACE™ equipment; members of the aforementioned UNIVERSAL POPULACE™ transportation; members of the aforementioned UNIVERSAL POPULACE™ manufacturing; members of the aforementioned UNIVERSAL POPULACE™ instruments; members of the aforementioned UNIVERSAL POPULACE™ railroad; members of the aforementioned UNIVERSAL POPULACE™ transit, members of the aforementioned UNIVERSAL POPULACE™ air, land and water conduits; members of the aforementioned UNIVERSAL POPULACE™ utilities; members of the aforementioned UNIVERSAL POPULACE™ wholesale; members of the aforementioned UNIVERSAL POPULACE™ retail merchandising; members of the aforementioned UNIVERSAL POPULACE™ treasuring; members of the aforementioned UNIVERSAL POPULACE™ accounting; members of the aforementioned UNIVERSAL POPULACE™ communicating; members of the aforementioned UNIVERSAL POPULACE™ transporting; members of the aforementioned UNIVERSAL POPULACE™ energizing; members of the aforementioned UNIVERSAL POPULACE™ fueling; members of the aforementioned UNIVERSAL POPULACE™ broadcasting; members of the aforementioned UNIVERSAL insurance; members of the aforementioned UNIVERSAL POPULACE™ real estate; members of the aforementioned UNIVERSAL POPULACE™ public services; members of the aforementioned UNIVERSAL POPULACE™ public administration; members of the aforementioned UNIVERSAL POPULACE™ health administration; members of the aforementioned UNIVERSAL POPULACE™ legal administration; members of the aforementioned UNIVERSAL POPULACE™ heretofore non-classifiable variables; wherefrom every and all aforementioned goods, products, services and supplies inclusive of every and all necessarily integrated, critically important and increasingly integral aforementioned PUBLIC FINANICALS instruments exchanges whether or not registered, listed and/or licensed market exchanges heretofore as physical, electronic, telephony, virtual and/or webpage data transport conduits transmitting to/from converting receivers realizing antiquated, archaic, ancient history and superannuated identifying, organizating, cataloging, indexing, categorizing and/or processing to ensure concretizing of methodological pooling and batch transmission to/from converting reciever traverse conduit data transport processing evincing further, without limitation, every and all of the following: antiquated, archaic, ancient history and superannuated physical, electronic, telephony, facsimile, virtual, dumb terminal and/or webpage veiled, hesitant, delayed, holding, time-lagged, restraining, raptorial and utterly inefficient instrument quotation, matching, clearance, settlement and exchange processing entailing, encompassing, comprising, involving, Impacting and/or effecting pestilent credit card processing, presumptous card check processing, portentous check draft processing, detrimental sparing electronic funds transport processing, debilitating time-lagged financial market data processing, importune information, pestiferous news, chalandrical commercials, bombarding advertisements, boisterous silkiers, imprudent propagations, harassing notices, imposing messages, demoralizing collections; uproarious mailings, speiling articles, spectacle fliers, impetuous circulars, insinuating letters, condescending directives, unfruitful pretending; glittering props, propositional designs, unreserved uploading, provacative displaying, unnerving postings, subsidizing tactics, unjustifiable speculations, sporadic searching, unauthorized downloading, superfluous dialoguing, delayed streaming, illegal spamming, defensive services, illegal slamming, spiteful defamations, illegal motivating, incentive returning, insolent discourse, damaging converse, veiled plying, guiled peeping, derogatory hacking, abstruse linking, deceptive twisting, obstructive coiling, feeler convoluting, referral coupling, insistent mixing, enthralled intertwining, restrictive interfacing, selective releasing, spinning updates, harassing reporting, imprinting announcements, hesitant pronouncements, pestering promotions, pressing tourism, spicing sponsoring, defamatory propitiating, portentuous soliciting, voracious contracting, subliminal propaganda, specious tracer, fragmenting editorials, pretending newsletters, sponsored newspapers, presuming periodicals, oppressing publications, bolstering magazines inclusive of every and all such national and transnational network broadcasting, distributing and/or syndicating transmission, rebroadcasting, redistributing and/or resyndicating transmission signal addressing stations; wherefrom whichever entailing, encompassing, comprising, involving, impacting and/or effecting every and all, without limitation, of the following general classifications, categorizations and/or stratifications of sectors and industries within, throughout and transcending the national sovereign borders of every and all of the industrialized, developed, developing free-market and trade bloc economies of a single holistically econometric marketplace environment: aforementioned PUBLIC FINANCIALS™ agriculture; aforementioned PUBLIC FINANCIALS™ construction; food aforementioned PUBLIC FINANCIALS™ foods; aforementioned PUBLIC FINANCIALS™ beverages; aforementioned PUBLIC FINANCIALS™ lumber; aforementioned PUBLIC FINANCIALS™ mining aforementioned PUBLIC FINANCIALS™ natural resources; aforementioned PUBLIC FINANCIALS™ textiles; aforementioned PUBLIC FINANCIALS™ primary metals; aforementioned PUBLIC FINANCIALS™ fabrics; aforementioned PUBLIC FINANCIALS™ machinery; aforementioned PUBLIC FINANCIALS™ computing; aforementioned PUBLIC FINANCIALS™ devices; aforementioned PUBLIC FINANCIALS™ electronics; aforementioned PUBLIC FINANCIALS™ equipment; aforementioned PUBLIC FINANCIALS™ transportation; aforementioned PUBLIC FINANCIALS™ manufacturing; aforementioned PUBLIC FINANCIALS™ instruments; aforementioned PUBLIC FINANCIALS™ railroad; aforementioned PUBLIC FINANCIALS™ transit; aforementioned PUBLIC FINANCIALS™ atmospheric and/or galatic outer space air, land PUBLIC FINANCIALS™ utilities; aforementioned PUBLIC FINANCIALS™ wholesale; aforementioned PUBLIC FINANCIALS™ retail merchandizing; aforementioned PUBLIC FINANCIALS™ treasuring; aforementioned PUBLIC FINANCIALS™ accounting; aforementioned PUBLIC FINANCIALS™ communicating; aforementioned PUBLIC FINANCIALS™ transporting; aforementioned PUBLIC FINANCIALS™ energizing; aforementioned PUBLIC FINANCIALS™ fueling; aforementioned PUBLIC FINANCIALS™ broadcasting; members of the aforementioned UNIVERSAL POPULACE™ distributing; aforementioned PUBLIC FINANCIALS™ financing; aforementioned PUBLIC FINANCIALS™ insurance; aforementioned PUBLIC FINANCIALS™ real estate; aforementioned PUBLIC FINANCIALS™ public services; aforementioned PUBLIC FINANCIALS™ public administration; aforementioned PUBLIC FINANCIALS™ health administration; aforementioned PUBLIC FINANCIALS™ legal administration; aforementioned PUBLIC FINANCIALS™ heretofore non-classifiable variables. Wherefrom it is an undeniable and evidentiary findings of fact, documented reference, logical scientific deduction and intutive analytical reasoning that every and all of the aforementiond so-called classifications, categorizations and/or stratifications of aforementioned PUBLIC FINANCIALS™ organizations engage in research, design, production, testing, manufacture, development, promotion, distribution and/or syndication generating so-called leads leveraged into so-called referrals which are inefficiently thereupon but without gurantees whatsoever turned into so-called contacts further potentially leading to so-called connections which may or may not facilitate entry into so-called networking circles, whereupon potentially greasing so-called appointments to enable on-site person-to-person interface thereunto creating further inefficient dealy which eventually may lead to a potential distribution whether contracted or otherwise. Wherefrom this cycle propagates eventual distribution and utility of every and all so-calleed products, goods, services and supplies via one form or another however one with so-called experience in any one particular sector or industry would find beneficial to their cause to obfuscate via every and all terminological denominative conveyance whichever heretofore obfuscating so-called disciplinary fields of involving traditionally separate and distinctively exclusive specialty areas to their own so-called sectors and industries within a intuitive analytical reasoning that every and all requisition, acquisition, distribution, transfer, leasing, purchasing and/or outright sale of products, goods, services and supplies so-called products, goods, services and supplies are necessarily, undeniably, logically, scientifically and intuitively exclusively consumed, leveraged, harnessed, ingested and/or utilized by individual members of the aforementioned UNIVERSAL POPULACE™ whichever directly and/or indirectly ultimately attributable to one or another individual, but whereupon all of whom are in one form or another, without any regard to limits, classifications, categorizations and/or stratifications related to socioeconomic background entailing, encompassing, comprising, involving, impacting and/or effecting, without limitation, birth right origin, heirship and/or access to wealth, property and/or currency or the lack thereof, wherefrom furthermore ensuring truth, justice and equal opportunity for all without discrimination to race, color, ethnicity, age, gender, languages, employment, legal status, national origin, religionn, or mential and/or physical disability. Moroever, it is an undeniable and evidentiary finding; of fact, documented reference, logical scientific deduction and intuitive analytical reasoning that every and all inefficient, ineffective, dysfunctional and fragmented aforementioned general and/or formulated classifictions, categorizations and/or stratifications of aforementioned PUBLIC FINANCIALS™ organizations heretofore and hereafter necessarily, undeniably, logically, scientifically and intuitively employ the greatest majority of the individual whom are either directly and/or indirectly impacte and/or effected from propagating, promulgating and proclaiming the products, goods, services and supplies produced, promoted and/or distributed via the antiquated, archaic, ancient history and superannuated so-called supply chains of these herein general and/or formulated aforementioned PUBLIC FINANCIALS™ organizations among the national sovereign industrialized, developed and developing free-market commerce and trade bloc economies within, throughout and transcending a single holistically econometric marketplace environment. Furthermore, wherefrom every and all aforementioned PUBLIC FINANCIALS™ orgnizations heretofore leverage, harness and utilize every and all of the aforementioned ancient history fragmented market inefficiencies to produce, promote and/or distribute their so-called products, goods, services and supplies via every and all of the communications seamlessly incorporating every and all of the every and all of the aforementioned herein general and formulated classifications, categorizations and/or stratifications entailing, encompassing, comprising, involviong, impacting and/or effecting every and all local, long-distance, domestic, transnational and/or multinational initiatives, schemes, ocurrences happenings, interactions, processes, methods, practices, movements, proceedings, messaging, presentations, notifications, filings, submissions, records, activities, actions, events, endeavors, tasks and affairs, effecuating and/or propagating whichever anytime, anyplace and anytime within, throughout and transcending a necessary, undeniable, evidentiary, logical, scientific and intuitively single global econometric marketplace environment, moreover every and all are heretofore necessarily engage in aiming to propagate, solicit, promulgate for production, promotion and/or distribution as targets, directly and/or indirectly, every and all, without limitation, of the following: hereto members of the aforementioned UNIVERSAL POPULACE™ wherefrom thereupon every and all are hereto further succinctly below exploded to evince every and all of the following so-called on-line and/or off-line software development, operating systems, network infrastructure and/or web-hosted network trading development article, apparatus and/or megastructure innovation, engineering, design, development, accounting, reconciling, auditing, reporting, communicating, broadcasting, energizing, fueling, production, manufacturing, promotion, distribution, tracking, transporting and financing instrument matching, clearing, executing, settling and exchanging aforementioned UCMOST™ real-time processing and/or reprocessing of data and/or information inclusive of, without limitation, the following aforementioned PUBLIC FINANCIALS™ organizations: so-called Microsoft Corporation; so-called JD Edwards; so-called Sabre Systems; so-called Seibel Systems, Inc.; so-called Computer Associates International, Inc.; so-called RealNetworks; so-called Palm Co.; so-called Network Associates; so-called Inktomi; so-called Intuit; so-called DoubleClick; so-called CheckFree; so-called Check Point Software; so-called Broadvision; so-called Excite@Home; so-called Telefonica's Terra-Lycos; so-called BEA Systems; so-called Ariba; so-called Akamai Technologies; so-called Sybase; so-called Citrix Systems; so-called Yahoo.com; so-called Unysis; so-called Sun MicroSystems; so-called Oracle Corporation; so-called Linux Open-Source; so-called Novell; so-called SAP; so-called called Amazon.com; so-called Cirrus Logic; so-called Openwave Systems; so-called Open Market, so-called The Open Croup so-called Red Hat, so-called i2 Technologies; so-called Cambridge Technology Partners; so-called Biz2Peer Technologies; so-called Quicken; so-called so-called Autodesk; so-called Informix; so-called Proxicom; so-called iXL; so-called MarchFirst; so-called Kliger-Weiss Information Systems; so-called New Era of Networks; so-called Blue Tiger Networks; so-called Consilient; so-called Endeavor Technologies; so-called FreeMarkets; so-called 1-800-Flowers.com; so-called FirstPeer; so-called Groove Networks; so-called Netrana; so-called Roku Technologies; so-called SmartPeer; so-called SportsLine.com; so-called webMethods; so-called WebMD.com; so-called 1-800-Flowers.com; so-called Tibco Software; so-called Universal Access; so-called Ultimate Software; so-called CNet; so-called BroadVision; so-called Veritas Software; so-called VeriSign; so-called so-called International Business Machines; inclusive of, without limitation, every and all of the following so-called hardware computing manufacture article, apparatus and/or megastructure innovation, engineering, design, development, accounting, reconciling, auditing, reporting, communicating, broadcasting, energizing, fueling, production, manufacturing, promotion, distribution, tracking, transporting and financing instrument matching, clearing, executing, settling and exchanging aforementioned UCMOST™ real-time processing and/or reprocessing of data and/or information inclusive of, without limitation, the following aforementioned PUBLIC FINANCIALS™ organizations: so-called Dell Corp.; so-called Hewlett Packard; so-called Compaq Computer Corp.; so-called Toshiba; so-called Gateway Computers; so-called Sony; so-called NCR; so-called NEC; so-called Diebold; so-called Pioneer, so-called Blaupunkt; so-called Hitachi; so-called Nokia; so-called International Business Machines, so-called Apple Computer, Inc.; and, without limitation, every and all of the following so-called semi-conductor chip article, apparatus and/or megastructure motor vehicle innovation, engineering, design, development, production, manufacturing, promotion, distribution, tracking, transporting and financing instrument matching, clearing, executing, settling and exchanging aforementioned UCMOST™ real-time processing and/or reprocessing of data and/or information inclusive of, without limitation, the following aforementioned PUBLIC FINANCIALS™ organizations: so-International/Applied Materials; inclusive of, without limitation, every and all of the following so-called hardware, area code and number telephony carrier network switching, wire jack line and/or wireless telecommunications article, apparatus and/or megastructure innovation, engineering, design, development, accounting, reconciling, auditing, reporting, communicating, broadcasting, energizing, fueling, production, manufacturing, promotion, distribution, tracking, transporting and financing instrument matching, clearing, executing, settling and exchanging aforementioned UCMOST™ real-time processing and/or reprocessing of data and/or information inclusive of, without limitation, the following aforementioned PUBLIC FINANCIALS™ organizations: so-called Charter Communications; so-called GTE; so-called American Telephone & Telegraph-AT&T; so-called SBC Communications; so-called Verizon Communications; so-called Ericsson; so-called Lucent Technologies; so-called Nokia; so-called VoiceStream; so-called ADC Telecommunications; so-called Ciena; so-called Verity; so-called Nextel; so-called Sprint Communications; so-called WorldCom; so-called Comcast; so-called Covad Communications; so-called Vignette; so-called AT&T-MediaOne; so-called Liberty Mutual; so-called BellSouth Corp.; so-called Telefonica; so-called Cingular; so-called Vodafone Group; so-called Scientific-Atlanta; so-called SouthWestern Bell; so-called Tellabs; inclusive of, without limitation, every and all of the following so-called internet and/or ethernet network routing and/or storage telecommunications and/or electronics article, apparatus and/or megastructure innovation, engineering, design, development, accounting, reconciling, auditing, reporting, communicating, broadcasting, energizing, fueling, production, manufacturing, promotion, distribution, tracking, transporting and financing instrument matching, clearing, executing, settling and exchanging aforementioned UCMOST™ real-time processing and/or reprocessing of data and/or information inclusive of, without limitation, the following aforementioned PUBLIC FINANCIALS™ organizations: so-called Cisco Systems; so-called Nortel Networks; so-called Lucent Technologies; so-called Motorola; so-called Owens-Corning; so-called Qualcomm; so-called Level 3 Communications; so-called EMC Corp.; so-called Copper Mountain; so-called Juniper Networks; so-called Exodus Communications; so-called Global Crossing; so-called Qwest Communications; so-called New World; so-called Iomega; so-called Energizer Batteries; so-called Matsushita Electric Industrial Co.; so-called Alkaline Battaries; so-called Cannon; so-called Fuji; so-called Fujitsu; so-called Nippon; so-called Nokia; Nipon Telecom; so-called Siemens; inclusive of, without limitation, every and all of the following so-called intellectual property governance, national administration, transnational administration, national and/or transnational tax billing and collection, insurance protection, public service, quasi-governmental mortgage banking, independent and/or quasi-regulatory agencies, community service, melodius, polity policy, public policy, public administration, analysis, union and/or professional association, humanitarian, transnational commerce and trade organizations, national, state, local and/or transnational courts of jurisprudence article, apparatus and/or megastructure innovation, engineering, design, development, accounting, reconciling, auditing, reporting, communicating, broadcasting, energizing, fueling, production, manufacturing, promotion, distribution, tracking, transporting and financing instrument matching, clearing, executing, settling and exchanging aforementioned UCMOST™ real-time processing and/or reprocessing of data and/or information inclusive of, without limitation, the following aforementioned PUBLIC FINANCIALS™ organizations: so-called Patent and Trademarket Office(s); so-called Patent and Trademarket Office(s); so-called U.S. Court of Appeals for the Federal Circuit; so-called U.S. Presidential Office; so-called U.S. Securities and Exchange Commission; so-called U.S. Department of Treasury; so-called U.S. Office of Thrift and Comptroller of the Currency; so-called U.S. Federal Trade Commission; so-called U.S. Department of State; so-called U.S. Bi-Cameral Congressional Forum; so-called U.S. Presidential Economic Advisors Committee; so-called Office of Management and Budget; so-called Government Accounting Office; so-called Congressional Budget Office; so-called U.S. Office of Attorney General; so-called U.S. Customs Service; so-called U.S. Immigration and Naturaliztion Service; so-called U.S. Center for Disease Control; so-called U.S. Food and Drug Administration; so-called U.S. Occupational Safety and Health Administration; so-called U.S. Department of Labor; so-called U.S. Bureau of Labor Statistics; so-called U.S. Department of Education; so-called U.S. Department of Health and Human Services; so-called U.S. Small Business Administration Offices; so-called U.S. State Attorney General Offices; so-called U.S. Futures Trade Commission; so-called U.S. Municipal Securities Regulatory Board; so-called U.S. Federal Reserve Board of Governors; so-called Government National Home Loan Mortgage; so-called Federal National Home Loan Mortgage; so-called Federal Home Loan Mortgage Corporation; so-called U.S. Federal Open Market Committee; U.S. Federal Reserve Bank; so-called U.S. Internal Revenue Service; so-called U.S. State Offices of Educational Assistance; so-called U.S. State Child and Family Services Offices; so-called U.S. State Welfare and Employment Assistance Services Offices; so-called Congress of Industrial Organizations; so-called U.S. Department of Defense; so-called U.S. Foreign Embassies; so-called U.S. Foreign Interests Sections; so-called U.S. National Security Agency; so-called U.S. Central Intelligence Agency; so-called U.S. Federal Bureau of Investigation; so-called U.S. Pentagon Station; so-called Office of Naval Intelligence; so-called U.S. Federal District Courts; so-called U.S. State Courts; so-called U.S. Department of Justice; so-called U.S. Postal Service; so-called U.S. District Courts; so-called U.S. Air Force Intelligence; so-called U.S. Army Intelligency; so-called U.S. Marine Corps Intelligence; so-called U.S. Bureau of Alcohol, Tobacco and Firearms; so-called U.S. Federal Communications Commission; so-called U.S. Department of Transportation; so-called U.S. Federal Aviation Administration; so-called U.S. Supreme Court; so-called U.S. Department of Energy; so-called U.S. Public Service Commission; so-called U.S. Federal Deposit Insurance Corporation; so-called U.S. Securities Investors Protection Corporation; so-called U.S. Chamber of Commerce; so-called Better Business Bureau; so-called Medical Information Bureau; so-called American Institute of Actuarial Sciences; so-called International Committee of Red Cross; so-called American Society of Public Administrators; so-called American Bar Association; so-called American Medical Association; so-called American Bankers Association; so-called International Federation of Bankers; so-called International Society of Financial Analysts; so-called Association of Investment Management and Research; National Investor Relations Institute; so-called National Credit Union Association; so-called National Association of Purchasing Managers; so-called American Civil Liberties Union; so-called American Veterans Association; so-called United Mine Workers; so-called United Automobile, Aerospace, and Agricultural Implement Workers; so-called United Automobile Workers; so-called Association; so-called International Trade Organization; so-called the International Confederation of Trade Among Countries; so-called World Bank; so-called International Monetary Fund; so-called International Bank of Economic Reconstruction and Development; so-called United Nationsl Relief and Works Agency; so-called United Nations Children's Fund; so-called United Nations Relief and Rehabilitation Administration; so-called United Nations Educational, Scientific, and Cultural Organization; so-called Organization for Economic Cooperation and Development; so-called Organization of American States; so-called International Monetary Fund; so-called World Bank; so-called United Nations, so-called International Association of Actuarial Sciences; so-called United Way; so-called American Red Cross; so-called World Trade Organization; so-called International Bank of Settlements; so-called Warring International Crimes Tribunal; so-called World Intellectual Property Organization; inclusive of, without limitation, every and all of the following inefficient, ineffective, dysfunctional, fragmented, antiquated, archaic, ancient history and obfuscating physical brick-and-mortar so-called equity and/or debt securities, stock, bond, option, future, forward, swap, commodity regulatory agencies, commissions, boards and/or exchange article, apparatus and/or megastructure innovation, engineering, design, development, accounting, reconciling, auditing, reporting, communicating, broadcasting, energizing, fueling, production, manufacturing, promotion, distribution, tracking, transporting and financing instrument matching, clearing, executing, settling and exchanging aforementioned UCMOST™ real-time processing and/or reprocessing of data and/or information inclusive of, without limitation, the following aforementioned PUBLIC FINANCIALS™ organizations: so-called U.S. Securities and Exchange Commission; so-called Commodities Futures Trade Commission; so-called Municipal Securities Regulatory Board; so-called Chicago Board of Trade; so-called Chicago Board of Options Exchange; so-called American Stock Exchange; so-called Pacific Stock Exchange; so-called Philadelphia Stock Exchange; so-called Chicago Mercantile Exchange; so-called New York Mercantile Exchange; so-called Over-the-Counter Pink-Sheets; so-called Depository Trust Corporation; so-called Securities Industry Protection Corporation; so-called Over-the-Counter Bulletin Board; so-called New York Stock Exchange; so-called National Inter-Trade System; so-called Malaysia Stock Exchange; so-called Singapore Stock Exchange; so-called Brazilian Stock Exchange; so-called China Stock Exchange; inclusive of, without limitation, every and all of the following inefficient, ineffective, dysfunctional, fragmented, antiquated, archaic, ancient history and obfuscating electronic telecommunications so-called securities exchange article, apparatus and/or megastructure innovation, engineering, design, development, accounting, reconciling, auditing, reporting, communicating, broadcasting, energizing, fueling, production, manufacturing, promotion, distribution, tracking, transporting and financing instrument matching, clearing, executing, settling and exchanging aforementioned UCMOST™ real-time processing and/or reprocessing of data and/or information inclusive of, without limitation, the following aforementioned PUBLIC FINANCIALS™ organizations: so-called Island ECN; so-called Redibook ECN; so. called Archipelago ECN; so-called Posit ECN; so-called Brut ECN; so-called Optimark ECN; so-called Attain ECN; so-called Strike ECN; so-called NexTrade ECN; so-called Datek ECN; so-called Tradebook ECN; so-called Knight/Trimark ECN; so-called National Association of Securities Dealers Automated Quotation System NASDAQ-ECN; so-called NYSE Superdot Trade System NYSE-ECN; so-called Bernard Madoff ECN; so-called Schwab ECN; so-called Ameritrade ECN; so-called E-Trade ECN; so-called Instinet ECN; inclusive of, without limitation, every and all of the following so-called legal, tax, accounting, reconciling, auditing and/or reporting consulting, assurance, preparation and/or guidance article, apparatus and/or megastructure innovation, engineering, design, development, accounting, reconciling, auditing, reporting, communicating, broadcasting, energizing, fueling, production, manufacturing, promotion, distribution, tracking, transporting and financing instrument matching, clearing, executing, settling and exchanging aforementioned UCMOST™ real-time processing and/or reprocessing of data and/or information inclusive of, without limitation, the following aforementioned PUBLIC FINANCIALS™ organizations: so-called Arthur Andersen, LLP; so-called Andersen Consulting-Accenture; so-called KPMG Peat Marwick, LLP; so-called KPMG Consulting, Inc.; so-called Ernst & Young, LLP; so-called Ernst & Young Consulting Group; so-called Deloitte & Touche, LLP; so-called Deloitte & Touche Consulting Group; so-called PriceWaterhouseCoopers, LLP; so-called Bowen, LLP; Venture Law Group; inclusive of, without limitation, every and all of the following so-called data, fund, securities, individual, health, humanitarian, meloduis, and/or organizational worthiness, credit, debtor, risk profiling, insured, beneficiary and/or information reporting and/or post mail article, apparatus and/or megastructure innovation, engineering, design, development, accounting, reconciling, auditing, reporting, communicating, broadcasting, energizing, fueling, production, manufacturing, promotion, distribution, tracking, transporting and financing instrument matching, clearing, executing, settling and exchanging aforementioned UCMOST™ real-time processing and/or reprocessing of data and/or information inclusive of, without limitation, the following aforementioned PUBLIC FINANCIALS™ organizations: so-called Electronic Data Gathering Automated Retrieval (EDGAR); so-called FreeEDGAR; so-called The Dialog Corp.-Bright Star; so-called Nexis/Lexis; so-called First Call/Thompson Financial; so-called Standard & Poor's; so-called Moody's Investors Services; so-called Dun & Bradstreet; so-called Value Line; so-called Morningstar; so-called Equifax; so-called Trans Union; so-called Experian; so-called U.S. Federal Reserve Board of Governors; so-called U.S. Federal Open Market Committee; U.S. Federal Reserve Bank; so-called U.S. Internal Revenue Service; so-called Federal Deposit Insurance Corporation; so-called Securities Investors Protection Corporation; so-called U.S. Center for Disease Control; so-called U.S. Food and Drug Administration; so-called U.S. Central Intelligency Agency; so-called U.S. Federal Bureau of Investigation; so-called U.S. Department of Defense; so-called U.S. Bureau of Alcohol Tobacco and Firearms; so-called U.S. Department of Energy; so-called U.S. Public Service Commission; so-called U.S. Federal Communications Commission; so-called Congress of Industrial Organizations; so-called U.S. Department of Treasury; so-called U.S. Office of Thrift and Comptroller of the Currency; so-called U.S. Department of Labor; so-called U.S. Department of Health and Human Services; so-called U.S. Occupational Safeety and Health Administration; so-called U.S. Securities and Exchange Commission; so-called Commodities Futures Trade Commission; so-called Municipal Securities Regulatory Board; so-called Medical Information Bureau; so-called American Institute of Actuarial Sciences; so-called International Association of Actuarial Sciences; so-called American Joint Underwriting so-called United Way; so-called American Red Cross; so-called International Committee of Red Cross; so-called Foreign Embassies; so-called Foreign Interests Sections; so-called American Society of Public Administrators; so-called American Bar Association; so-called American Medical Association; so-called American Bankers Association; so-called International Federation of Bankers; so-called International Society of Financial Analysts; so-called Association of Investment Management and Research; National Investor Relations Institute; so-called National Credit Union Association; so-called National Association of Purchasing Managers; so-called American Civil Liberties Union; so-called American Veterans Association; so-called United Mine Workers; so-called United Automobile, Aerospace, and Agricultural Implement Workers; so-called United Automobile Workers; so-called Center for Democracy and Technology; so-called National Labor Relations Union; so-called National Association of American Colored Persons; so-called American Marketing Association; inclusive of, without limitation, every and all of the following so-called business services, news reporting, newspaper, advertisement, marketing and/or electronic media and/or so-called new media article, apparatus and/or megastructure innovation, engineering, design, development, accounting, reconciling, auditing, reporting, communicating, broadcasting, energizing, fueling, production, manufacturing, promotion, distribution, tracking, transporting and financing instrument matching, clearing, executing, settling and exchanging aforementioned UCMOST™ real-time processing and/or reprocessing of data and/or information inclusive of, without limitation, the following aforementioned PUBLIC FINANCIALS™ organizations: so-called Microsoft Ultimate TV; so-called Walt Disney; so-called Associated Press; so-called United Press International; so-called Dow Jones Co.; so-called Reuters PLC; so-called Bloomberg; so-called Bridge Information Services; so-called Business Wire; so-called MSNBC; so-called Gannett; so-called Knight/Ridder Co.-Miami Herald; so-called Dow Jones Co.; so-called Dow Jones-The Wall Street Journal; Dow Jones Co.-The International Financial Times; so-called Tribune; so-called The Economist Newspaper Group, Inc.; so-called Nielson Media Ratings; so-called Gallup Media Polling; so-called New York Times; so-called News Corp.; so-called Barron's Magazine; so-called Chicago Tribune; so-called Chicago Times; so-called Post; so-called Washington Times; so-called Magazine Publishers of America; so-called Yahoo; so-called CNNFN; so-called CNBC; so-called CNN; so-called Viacom; so-called Clear Channel Communications; so-called Direct TV; so-called OmniCom; so-called Satchi & Satchi; so-called Public Broadcasting Station; inclusive of without limitation, every and all of the following so-called currency money depositing, withdrawing, transporting, letter of crediting, equity lining, credit lining, revolving credit lining, credit cards issuance, debit card issuance, prepaid debit card issuance, check draft card issuance, certified check daft issuance, and individual, partnership, company, merchant, commercial, associational, governmental, retail and/or mortgage banking, securities and insurance article, apparatus and/or megastructure innovation, engineering, design, development, accounting, reconciling, auditing, reporting, communicating, broadcasting, energizing, fueling, production, manufacturing, promotion, distribution, tracking, transporting and financing instrument matching, clearing, executing, settling and exchanging aforementioned UCMOST™ real-time processing and/or reprocessing of data and/or information inclusive of, without limitation, the following aforementioned PUBLIC FINANCIALS™ organizations: so-called Goldman Sachs; so-called Merrill Lynch; so-called Prudential Securities; so-called UBS PaineWebber Group; so-called UBS Warburg; so-called Bear Stearns; so-called CS First Boston; so-called CS Alex Brown; so-called Citigroup Smith Barney; so-called First Union Corp.; so-called Bank One Securities; so-called Depository Trust Corporation; so-called Bank of New York; so-called State Street Bank; so-called Fiserv; so-called Raymond James & Associates; so-called General Electric Company; so-called Chase Manhattan; so-called Citigroup; so-called CitiStreet; so-called JP Morgan Corp.; so-called Bank of America; so-called NationsBank; so-called Union Planters Bank; so-called ABN AMRO; so-called Wells Fargo Bank; so-called Riggs National Bank; so-called Fleet National Bank; so-called Regent Bank; so-called ING Direct Bank; so-called ING Barring's; so-called U.S. Federal Reserve Board of Governors; so-called U.S. Federal Open Market Committee; U.S. Federal Reserve Bank; so-called U.S. Internal Revenue Service; so-called Federal Deposit Insurance Corporation; so-called Securities Investors Protection Corporation; so-called International Bank of Settlements; so-called World Bank; so-called International Monetary Fund; so-called United Nations Relief and Rehabilitation Administration; so-called United Nations Educational, Scientific, and Cultural Organization; so-called Government National Home Loan Mortgage; so-called Federal National Home Loan Mortgage; so-called Federal Home Loan Mortgage Corp.; so-called U.S. Postal Service; so-called Providian Bank; so-called Bank One; so-called Providian National Bank; so-called USAccess Bank; so-called Washington Mutual; so-called BankAtlantic; so-called Bank of Boston; so-called BankUnited; so-called Colonial Bank; so-called SunTrust Bank; so-called Wachovia Bank; so-called Republic Bank of New York; so-called International Republic Bank of Miami; so-called Mellon United National Bank; so-called First Chicago Bank; so-called Northern Trust Bank; so-called Israeli International Bank of New York; so-called BAC Florida Bank; so-called City National Bank of Florida; so-called Continental National Bank of Miami; so-called Coconut Grove Bank; so-called Commercebank; so-called Commercial Bank of Florida; so-called Continental Bank of Florida; so-called Eastern National Bank; so-called Espirito Santo Bank of Florida; so-called Banco Popular; so-called Banco Santander de Espana; so-called Banco International de Venezuela; so-called First National Bank of South Miami; so-called HSBC Bank USA; so-called Hamilton Bank; so-called Ocean Bank; so-called Pacific National Bank; so-called PineBank; so-called Republic Bank; so-called Republic Security Bank; so-called SouthTrust Bank; so-called TotalBank; so-called AmTrust Bank; so-called Desjardins Federal Savings Bank; so-called Fidelity Federal Bank and Trust; so-called Merrill Lynch Bank and Trust; so-called Comerica Bank; so-called Gibraltar Bank; so-called Interamerican Bank; so-called Third Federal Savings and Loan; so-called Turnberry Bank; so-called UniBank; so-called World Savings Bank; so-called American National Bank; so-called Florida Savings Bank; so-called Gulf Bank of Miami; so-called Great Eastern Bank of Florida; so-called Horizon Federal Savings Bank; so-called International Finance Bank; so-called OptimumBank; so-called Peninsula Bank; so-called Nexity Bank; so-called Capital One Federal Savings Bank; so-called Bank of Internet USA; so-called GiantBank.com; so-called E-Trade Bank. com; so-called NetBank; so-called IndyMac Bank Federal Savings Bank; so-called Provident Bank; so-called First Trade Union Bank of Boston; so-called Discover Bank; so-called Cross Country Bank; so-called Key Bank USA; so-called Fidelity Cash Schwab Value Advantage Accounts; so-called Merrill Lynch Cash Management Accouns; so-called Morgan Stanley Dean Witter Active Money Accounts; so-called USB PaineWebber Resource Management Accounts; so-called Centennial Money Market Accounts; so-called Prudential Command Money Accounts; so-called Wells Fargo Money Market Accounts; so-called Wells Fargo Cash Investment Money Market Accounts; so-called Alliance Capital Reserve Accounts; so-called Evergreen Money Market Accounts; so-called Bank of America Mortgage; so-called Chase Manhattan Mortgage Corp.; so-called CommerceBank National Association; so-called CountryWide Home Loans; so-called Eastern Financial Federal Credit Union; so-called Equitable Mortgage Services, Inc.; so-called Fidelity Mortgage Trust Corp.; so-called FHNET.com; so-called First Union Mortgage Corp.; so-called Home Financing Center, Inc.; so-called Union Planters Mortgage; so-called Viking Financial Services; so-called Jefferson Pilot Financial Services; so-called Washington Mutual Mortgage; so-called Worldwide Lending; inclusive of, without limitation, every and all of the following so-called insurance data, information, policy, contract, captive and/or alternative risk financing banking article, apparatus and/or megastructure innovation, engineering, design, development, accounting, reconciling, auditing, reporting, communicating, broadcasting, energizing, fueling, production, manufacturing, promotion, distribution, tracking, transporting and financing instrument matching, clearing, executing, settling and exchanging aforementioned UCMOST™ real-time processing and/or reprocessing of data and/or information inclusive of, without limitation, the following aforementioned PUBLIC FINANCIALS™ organizations: so-called Federal Deposit Insurance Corporation; so-called Securities Investors Protection Corporation; so-called Medical Information Bureau: so-called American International Group; so-called American General; so-called Chubb; so-called Prudential Corp. of America; so-called Northwestern Mutual; so-called New York Life; so-called MetLife; so-called Hartford Financial Services; so-called Massachusetts Mutual; so-called SunAmerica Financial Services; so-called Loews-CNA; so-called Pinnacle Financial Services; so-called Cigna Financial Services; so-called United Health; so-called Columbia Health; so-called Assurant; so-called TransAmerica; so-called Zurick Insurance; so-called ING Aetna Financial Services; so-called State Farm Insurance; so-LLC; Equitable; so-called Society Lloyd's of London Syndicate; inclusive of, without limitation, every and all of the following so-called individual retirement account so-called (IRA) banking, so-called deferred compensation retirement account so-called 401(K) banking, so-called defined benefit retirement account banking 501(c)(3), so-called mutual fund individual accounting banking, so-called annuity contract individual account banking and/or so-called insurance individual account banking article, apparatus and/or megastructure innovation, engineering, design, development, accounting, reconciling, auditing, reporting, communicating, broadcasting, energizing, fueling, production, manufacturing, promotion, distribution, tracking, transporting and financing instrument matching, clearing, executing, settling and exchanging aforementioned UCMOST™ real-time processing and/or reprocessing of data and/or information inclusive of, without limitation, the following aforementioned PUBLIC FINANCIALS™ organizations: so-called Securities Investors Protection Corporation; so-called Franklin Templeton Group; so-called FMR Research-Fidelity Investments; so-called Vanguard Group; so-called Janus Group; so-called Growth Fund of America; so-called Oppenheimer Group; so-called Putnam: so-called Invesco, so-called T. Rowe Price; so-called American Century; so-called Columbia Growth; so-called American Investment Management; so-called Alliance Capital; so-called Sun America; so-called Pimco; so-called Massachusetts Financial Services; so-called Seligman; so-called Van Kampen; Schwab Retirement Services; so-called General Electric Asset Management; so-called First Union National Bank; so-called Citigroup-CitiStreet; so-called Bank of America; so-called Bank of New York; so-called BiSys Plan Services; so-called Cigna Retirement & Investment; so-called Diversified Investment Advisors; so-called Dreyfus Retirement Services; so-called Great West Life Insurance & Annuity Insurance; so-called ING Aetna Financial Services; so-called Invesco Retirement; so-called JP Morgan-American Century; so-called Morgan Stanley Dean Witter; so-called UBS PaineWebber Group; so-called Citigroup-Smith Barney; so-called Merrill Lynch, Pierce, Fenner & Smith; so-called Credit Suisse Asset Management; so-called Key Asset Management; so-called MFS Investment Management; so-called M & I Trust & Investment Management; so-called Milliman & Robertson; so-called ManuLife Financial; so-called MassMutual Retirement; so-called NationWide Financial; Fargo; so-called New York Life Investment; so-called Northern Trust Retirement; so-called American Association of Retired Persons; so-called Armed Forces Financial Network; so-called United Teachers American Association; so-called USAA; so-called Waddell & Reed; so-called American Express Funds; so-called American Funds; so-called American Skandia; so-called Bernstein; so-called Black Rock; so-called UBS CS WarburgPincus; so-called Nicolas Applegate; so-called Evergreen; so-called Eaton Vance; so-called Dresdner Investments; so-called Scudder Investments; so-called Diversified Investments; so-called Dimensional; so-called Dutsche Banc; so-called Delaware; so-called Davis; so-called Excelsior; so-called Federtated; so-called Gabelli; so-called Galaxy; so-called Julius Baer; so-called Kemper; so-called John Hancock; so-called Mainstay; so-called Neuberger & Berman; so-called Strong; so-called Phoenix; so-called Lord Abbot; so-called Lazard Feres; so-called Legg Mason; so-called Liberty; so-called Guardian; so-called Hartford; so-called Russell; so-called Pioneer; so-called Price; so-called Nuveen; so-called One Group; so-called State Street; so-called Safeco; so-called CPM Group; so-called Barrick; so-called Goldman Sachs; inclusive of, without limitation, every and all of the following so-called automated teller machine, credit card, debit card, check card, prepaid cards, currency draft inclusive of so-called travelers' check draft order article, apparatus and/or megastructure innovation, engineering, design, development, accounting, reconciling, auditing, reporting, communicating, broadcasting, energizing, fueling, production, manufacturing, promotion, distribution, tracking, transporting and financing instrument matching, clearing, executing, settling and exchanging aforementioned UCMOST™ real-time processing and/or reprocessing of data and/or information inclusive of, without limitation, the following aforementioned PUBLIC FINANCIALS™ organizations: so-called Federal Deposit Insurance Corporation; so-called Wells Fargo; so-called JCB Cards; so-called Cirrus; so-called International Automated; so-called Donlen; so-called Mastercard International; so-called Visa International; so-called American Express Card Services; so-called Diner's International; so-called Carte Blanche; so-called MSDW Discover/Novus; so-called Wright Express; so-called Voyager; so-called PHH Service; so-called Priceline.com; so-called Explore; so-called Honor; so-called Explore; so-called Interlink; so-called NYCE: so-called called MPACT; so-called Maestro; so-called Tyme; so-called CheckMate; so-called Jeanie; so-called Quest; so-called Star; so-called Money Station; so-called E-Loan; so-called California Official State Fuel; so-called Credit Union Member Access; so-called Armed Services Financial Network; so-called Bank One; so-called Wachovia Bank Card Services; so-called Associates Card Services; so-called Metropolitan National Bank; so-called Simmons First National Bank; so-called USAA Savings Bank; so-called Capital One Bank; so-called AFBA Industrial Bank; so-called Amalgamated Bank of Chicago; so-called AmTrust Bank; so-called Ohio Savings Bank; so-called Fleet Bank; so-called First Internet Bank of Indiana; so-called Security First Network Bank; so-called Metropolitan Sank and Trust; so-called sovereign Bank; so-called SunTrust Bank; so-called First Union National Bank; so-called First Chicago Bank; so-called Union Planters Bank; so-called Republic security Bank; so-called Ocean Bank; so-called Western Union; so-called Money Gram; so-called Telecheck; so-called U.S. Postal Service; so-called Chase Manhattan Bank; so-called State Farm Insurance; so-called All State Insurance; inclusive of, without limitation, every and all of the following so-called associational, standards, financial, accounting, insurance, alternative risk mangement, melodius, medical, tax, legal, economic, polity policy, public administration, civility, humanitarian, diplomatic and/or municipal networking, discourse and indirect article, apparatus and/or megastructure innovation, engineering, design, development, accounting, reconciling, auditing, reporting, communicating, broadcasting, energizing, fueling, production, manufacturing, promotion, distribution, tracking, transporting and financing instrument matching, clearing, executing, settling and exchanging aforementioned UCMOST™ real-time processing and/or reprocessing of data and/or information inclusive of, without limitation, the following aforementioned PUBLIC FINANCIALS™ organizations: so-called U.S. Securities and Exchange Commission; so-called Commodities Futures Trade Commission; so-called Municipal Securities Regulatory Board; so-called Federal Deposit Insurance Corporation; so-called Securities Investors Protection Corporation; so-called American Institute for Certified Public Accountants; so-called Association for Financial Professionals; so-called the Conference Board's CFO Council; so-called ExecuNet; so-called Financial Executives International; so-called The Financial Executives Networking Group; so-called National called U.S. Chamber of Commerce; so-called National Association of Performing Artists; so-called Recording Industry Association of America; so-called Medical Information Bureau, so-called American Joint Underwriting Association, so-called Florida Windstorm Underwriting Association; so-called American Institute of Actuarial Sciences; so-called International Association of Actuarial Sciences; so-called U.S. Federal Reserve Board of Governors; so-called U.S. Federal Open Market Committee; U.S. Federal Reserve Bank; so-called U.S. Internal Revenue Service; so-called U.S. Center for Disease Control; so-called U.S. Food and Drug Administration; so-called U.S. National Security Agency; so-called Office of Naval Intelligence; so-called U.S. Air Force Intelligence; so-called U.S. Army Intelligency; so-called U.S. Marine Corps Intelligence; so-called U.S. Department of Treasury; so-called U.S. Office of Thrift and Comptroller of the Currency; so-called U.S. Department of Health and Human Services; so-called U.S. Center for Disease Control; so-called U.S. Department of Energy; so-called U.S. Public Service Commission; so-called U.S. Federal Communications Commission; so-called U.S. Federal Trade Commission; so-called Office of Management and Budget; so-called Government Accounting Office; so-called Congressional Budget Office; so-called U.S. Public Service Commission; so-called U.S. State Attorney General Offices; so-called U.S. State Securities Administrators Offices; so-called U.S. State Insurance Administors Offices; so-called U.S. State Child and Family Services Offices; so-called U.S. State Welfare and Employment Assistance Services Offices; so-called U.S. Department of Education; so-called U.S. State Offices of Educational Assistance; so-called U.S. Small Business Administration Offices; so-called U.S. Immigration and Naturalization Service; so-called United Way; so-called American Red Cross; so-called International Committee of Red Cross; so-called Foreign Embassies; so-called Foreign Interests Sections; so-called American Society of Public Administrators; so-called American Bar Association; so-called American Medical Association; so-called American Bankers Association; so-called International Federation of Bankers; so-called International Society of Financial Analysts; so-called Association of Investment Management and Research; National Investor Relations Institute; so-called National Credit Union Association; so-called National Association of Purchasing Managers; so-called U.S. Bureau of Labor Statitics; so-called Implement Workers; so-called United Automobile Workers; so-called Center for Democracy and Technology; so-called National Labor Relations Union; so-called National Association of American Colored Persons; so-called Better Business Bureau; so-called Electronic Frontier Foundation; so-called International Organization for Standardization; so-called Interoperability Working Group; so-called Internet Corporation for Assigned Names and Numbers; so-called InfiniBank Trade Association; so-called World Wide Web Consortium; so-called Forrester Research Group; so-called Cato Institute; so-called Washington Association of Correspondents; so-called National Association of Performing Artists; so-called Moving Pictures Experts Group; so-called Motion Picture Association of America; so-called Recording Industry Association of America; so-called National Cable Television Association; so-called American Marketing Association; so-called International Trade Organization; so-called the International Confederation of Trade Among Countries; so-called International Bank of settlements; so-called World Bank; so-called International Monetary Fund; so-called International Bank of Economic Reconstruction and Development; so-called United Nationsl Relief and Works Agency; so-called United Nations Children's Fund; so-called United Nations Relief and Rehabilitation Administration; so-called United Nations Educational, Scientific, and Cultural Organization; so-called Organization for Economic Cooperation and Development; so-called Organization of American States; inclusive of, without limitation, every and all of the following so-called furnishing, electronics, home gardening and/or appliance home products article, apparatus and/or megastructure innovation, engineering, design, development, accounting, reconciling, auditing, reporting, communicating, broadcasting, energizing, fueling, production, manufacturing, promotion, distribution, tracking, transporting and financing instrument matching, clearing, executing, settling and exchanging aforementioned UCMOST™ real-time processing and/or reprocessing of data and/or information inclusive of, without limitation, the following aforementioned PUBLIC FINANCIALS™ organizations: so-called Procter & Gamble; so-called Gillette; so-called Colgate Palmolive; so-called Clorox; so-called Avon Products; inclusive of, without limitation, every and all of the following so-called nutritional food and poultry inclusive of melodius, fabric, textile, hygiene and janitorial, and physical and/or electronic auditing, reporting, communicating, broadcasting, energizing, fueling, production, manufacturing, promotion, distribution, tracking, transporting and financing instrument matching, clearing, executing, settling and exchanging aforementioned UCMOST™ real-time processing and/or reprocessing of data and/or information inclusive of, without limitation, the following aforementioned PUBLIC FINANCIALS™ organizations: so-called Wal-Mart Superstores; so-called Home Depot Superstores; so-called HomeStore.com; so-called Loews; so-called Eckerd's DrugStores; so-called CVS; so-calledd Walgreens Drug Stores; so-called Kohls Superstores; so-called Publix Supermarkets; so-called Winn Dixie Supermarkets; so-called Albertson's Supermarkets; so-called Piggly Wiggly Supermarkets; so-called Food Grocer; so-called Sam's Warehouse Club; so-called J & B Warehouse Club; so-called Costco; so-called Circuit City; so-called Comp USA, so-called RadioShack; so-called RadioShack.com; so-called Best Buy; so-called Bartlessmanns Music Group; so-called RCA Records; so-called Sony Music; so-called EMI International; so-called Warner Brothers Records; so-called Vivendi-Universal Music Group; so-called Disa Records; so-called INDIE Fonovisa; so-called Arista Records; so-called Virgin Records; so-called Billboard Music; so-called Univision Music Group; so-called Specs Music Stores; so-called Virgin Music Stores; so-called Peaches Music Stores; so-called Blockbuster Music Stores; so-called Sam Goodies Music Stores; o-calledNapster.com; so-called MP3.com; so-called so-called Lurias; so-called Kmart; so-called Office Depot; so-called Staples; so-called Viking; so-called Office Max; so-called Service Merchandise; so-called NAPA Auto Parts; so-called Petsmart Superstores; so-called Target; so-called TJ Maxx; so-called Marshalls; so-called Ace Hardware; so-called True Value Hardware; so-called Rooms-to-Go; so-called City Furniture; so-called Starbucks Coffee; so-called Border's; so-called Barne's and Nobles; so-called Amazon.com, Inc.; so-called eBay.com; so-called Yahoo.com; so-called Travelocity.com; so-called Stamps.com; so-called 1-800-Flowers.com; so-called Priceline.com; so-called Harrah's; so-called Sears Roebuck; so-called JC Penny; so-called Lord & Taylor; so-called Saks Fifth Avenue; so-called Bloomingdales; so-called Burdines; so-called Federated; inclusive of, without limitation, every and all of the following so-called nutritional food and poultry fast-food, entertainment, preference, auditing, reporting, communicating, broadcasting, energizing, fueling, production, manufacturing, promotion, distribution, tracking, transporting and financing instrument matching, clearing, executing, settling and exchanging aforementioned UCMOST™ real-time processing and/or reprocessing of data and/or information inclusive of, without limitation, the following aforementioned PUBLIC FINANCIALS™ organizations: so-called Morton Steakhouse; so-called Capital Grille Steakhouse; so-called Michael Jordan's Steakhouse; so-called Don Shula's Steakhouse; so-called Dave and Busters; so-called Applebee's; so-called TJI Friday's; so-called Outback Steakhouse; so-called Olive Garden; so-called Red Lobster; so-called Long John Silver; so-called Coco Cola Bottling; so-called Pepsico Bottling; so-called H.J. Heinz; so-called Unilever; so-called Campbell Soup; so-called Phillip Morris-Kraft Foods; so-called Liggett Co.; so-called RJR-Nabisco; so-called McDonald's; so-called Burger King; so-called Wendy's; so-called Denny's; so-called Arbys; so-called Checkers; so-called Tace Bell; so-called Kentucky Fried Chicken; so-called Checkers; so-called SubWay; so-called Pizza Hut; so-called Domino's Pizza; so-called Godfather's Pizza; so-called Papa John's Pizza; so-called Little Caesar's Pizza; so-called 7 Eleven Stores; inclusive of, without limitation, every and all of the following so-called agriculture manufacturing article, apparatus and/or megastructure innovation, engineering, design, development, accounting, reconciling, auditing, reporting, communicating, broadcasting, energizing, fueling, production, manufacturing, promotion, distribution, tracking, transporting and financing instrument matching, clearing, executing, settling and exchanging aforementioned UCMOST™ real-time processing and/or reprocessing of data and/or information inclusive of, without limitation, the following aforementioned PUBLIC FINANCIALS™ organizations: so-called Cargill; so-called Phoenix Hybrid; so-called Monsanto; so-called Continental Grain; so-called Archer Daniels Midland; so-called Royal Dutch NV; inclusive of, without limitation, every and all of the following so-called garbage collection, disposal and incinerating article, apparatus and/or megastructure innovation, engineering, design, development, accounting, reconciling, auditing, reporting, communicating, broadcasting, energizing, fueling, production, manufacturing, promotion, distribution, tracking, transporting and financing instrument matching, clearing, executing, settling and FINANCIALS™ organizations: so-called Allied Waste, Inc.; so-called Browning & Ferris; so-called Waste Management International; inclusive of, without limitation, every and all of the following so-called pharmaceutical drug manufacturing article, apparatus and/or megastructure innovation, engineering, design, development, accounting, reconciling, auditing, reporting, communicating, broadcasting, energizing, fueling, production, manufacturing, promotion, distribution, tracking, transporting and financing instrument matching, clearing, executing, settling and exchanging aforementioned UCMOST™ real-time processing and/or reprocessing of data and/or information inclusive of, without limitation, the following aforementioned PUBLIC FINANCIALS™ organizations: so-called Pfizer; so-called Glaxco Wellcome; so-called Schering Plough; so-called Roche Laboratories; so-called American Home Products; so-called Merck; so-called Johnson & Johnson; so-called Bristol-Meyers Squibb; so-called Pharmacia; so-called Eli Lilly; inclusive of, without limitation, every and all of the following so-called optic, glass, fiber, copper, electrical, biotechnology and chemical research, manufacturing and development article, apparatus and/or megastructure innovation, engineering, design, development, accounting, reconciling, auditing, reporting, communicating, broadcasting, energizing, fueling, production, manufacturing, promotion, distribution, tracking, transporting and financing instrument matching, clearing, executing, settling and exchanging aforementioned UCMOST™ real-time processing and/or reprocessing of data and/or information inclusive of, without limitation, the following aforementioned PUBLIC FINANCIALS™ organizations: so-called Amgen; so-called Medimmune; so-called Biogen; so-called Chiron; so-called Dupont; so-called Dow Chemical; so-called Union Carbide; so-called PPG Industries; so-called Air Products and Chemicals; so-called Rohm and Hass; inclusive of, without limitation, every and all of the following so-called logistics and/or so-called industrial manufacturing article, apparatus and/or megastructure innovation, engineering, design, development, accounting, reconciling, auditing, reporting, communicating, broadcasting, energizing, fueling, production, manufacturing, promotion, distribution, tracking, transporting and financing instrument matching, clearing, executing, settling and exchanging aforementioned UCMOST™ real-time processing and/or reprocessing of data and/or information inclusive of, without limitation, the following Works; so-called Ingersoll-Rand; inclusive of, without limitation; every and all of the following so-called forest paper and/or corrugated box manufacturing article, apparatus and/or megastructure innovation, engineering, design, development, accounting, reconciling, auditing, reporting, communicating, broadcasting, energizing, fueling, production, manufacturing, promotion, distribution, tracking, transporting and financing instrument matching, clearing, executing, settling and exchanging aforementioned UCMOST™ real-time processing and/or reprocessing of data and/or information inclusive of, without limitation, the following aforementioned PUBLIC FINANCIALS™ organizations: so-called Kimberly-Clark; so-called Georgia Pacific; so-called International Paper; so-called Chesapeake Corp.; so-called St. John's; so-called Weyerhaeuser; so-called Willamette Industries; inclusive of, without limitation, every and all of the following so-called letter, package, corrugated box and article mailing, shipping and/or freight carrier article, apparatus and/or megastructure innovation, engineering, design, development, accounting, reconciling, auditing, reporting, communicating, broadcasting, energizing, fueling, production, manufacturing, promotion, distribution, tracking, transporting and financing instrument matching, clearing, executing, settling and exchanging aforementioned UCMOST™ real-time processing and/or reprocessing of data and/or information inclusive of, without limitation, the following aforementioned PUBLIC FINANCIALS™ organizations: so-called Federal Express Corp.; so-called United Parcel Service, Inc.; so-called DHL; so-called U.S. Postal Service; inclusive of, without limitation, every and all of the following so-called timepiece, portable watch, fixtured clock and/or spatiotemporal time carrier article, apparatus and/or megastructure innovation, engineering, design, development, accounting, reconciling, auditing, reporting, communicating, broadcasting, energizing, fueling, production, manufacturing, promotion, distribution, tracking, transporting and financing instrument matching, clearing, executing, settling and exchanging aforementioned UCMOST™ real-time processing and/or reprocessing of data and/or information inclusive of, without limitation, the following aforementioned PUBLIC FINANCIALS™ organizations: so-called Rolex; so-called Seiko; so-called Timex; so-called Quartz; so-called Bulova; inclusive of, without limitation, wherefrom, further, atmospheric, aboveground, underground, underwater, pathogenesis, metalurgy, devises, devices, aeronautical, cosmological, typographical, oceanographical, bibliographic, physicalistic, biological cytogenetic, and ionizing natural, chemical, physical and behavioral geological, airway magnetic and/or thermomagnetic biohazardous regulated elements, components, constituents, factors, ingredients, processes, methods and/or combinations involving every and all illegitimate individualized criminality, illegitimate bibliolatrous criminality, illegitimate mafia organized criminality, and/or unilateral, bilateral and/or multilateral commissioned military armed service affairs and/or strategic covert operations involving every and all tangible inclusive intangible portable and/or fixtured continuous spectrum and/or orthorhombic conic section projection plane surface, atmospheric, nautical, ground wave, airway, airspace, aerospace and/or aeronautical plane low-frequency, mid-frequency, high-frequency, infrared, ultraviolet and/or geomagnetic weaponry inclusive of, without limitation, hereafter supplanting every and all so-called AEGIS, so-called Kidd-class, and so-called Kilo-class systems, heretofore utilized in threatening; intimidating; tyrannizing; interfering; dehumanizing; torturing; eradicating; executing; distressing; coercing, inclusive of, without limitation, heretofore every and all: binoculars; scopes; vision eye articles; vision goggles; vision masks; vision scopes; gaseous masks; gaseous suits; bayonets; arms; guns; rifles; equalizers; ammunitions; artillery; muzzlers; star shells; ballistics; dynamites; bombs; mines; bouncing mines; mines; grenades; lasers; cannons; barrels; ions; iodines; biomechanics; bioastronautics; pathogens; magnetics; bibliotics; cytogenetics; bionics; biophysics; biochemical; hydraulics; airborne pathogens; gasses; missles; shells; rockets; stealth articles; jetfighters; jetfighters helicopters; fighter-bombers; tanks; amphibious articles; vehicles; destroyers; carriers; chambers; launchers; silencers; artificial satellites; ships; submarines; shuttles; biosatellites; capsules; pods; pads; combs; trains; silos; megastructures; robotics; apparatuses; articles; whereas, entailing, encompassing, involving, entailing, impacting and effecting article, apparatus and/or megastructure innovation, engineering, design, development, accounting, reconciling, auditing, reporting, communicating, broadcasting, energizing, fueling, production, manufacturing, promotion, distribution, tracking, transporting and financing instrument matching, clearing, executing, settling and exchanging aforementioned UCMOST™ real-called General Dynamics; so-called Newsport News Shipbuilding; so-called Smith & Wesson; so-called Boeing, so-called General Electric, so-called UnitedAirlines, so-called Northwest Airlines; so-called Continental Airlines; so-called AMR-American Airlines; so-called SouthWest Airlines; so-called Trans World Airlines; so-called Delta Airlines; so-called National Aeronautical Space Administration; so-called US Airways; so-called McDonald Douglass; so-called Lockheed Martin; so-called Northrop Grunmman; so-called Raytheon; so-called Honeywell International/Applied Materials; so-called Airbus; inclusive of, without limitation, every and all of the following so-called overnight inns, motels, hotels, casinos, showcase, nightlife, restaurnat, dining and resort management article, apparatus and/or megastructure innovation, engineering, design, development, accounting, reconciling, auditing, reporting, communicating, broadcasting, energizing, fueling, production, manufacturing, promotion, distribution, tracking, transporting and financing instrument matching, clearing, executing, settling and exchanging aforementioned UCMOST™ real-time processing and/or reprocessing of data and/or information inclusive of, without limitation, the following aforementioned PUBLIC FINANCIALS™ organizations: so-called MGM Grand Casino Hotel & Resort; so-called Taj Mahal Grand Casino Hotel & Resort; so-called Park Plaza Hotel; so-called Sheridan Hotel & Resort; so-called Marriott Hotel & Resort; so-called Radisson Hotel & Resort; so-calle Hotel Sofitel; so-called Biltmore Hotel; so-called Doubletree Hotels; so-called Hampton Inn; so-called Redroof Inn; so-called Days Inn; so-called Ramada Inn; so-called Comfort Inn, so-called so-called Princess Bahamas Casino Hotel & Resort, so-called Monaco Grand Casino Hotel & Resort; so-called Morraco Grand Casino Hotel & Resort; inclusive of without limitation, every and all of the following sefl-impetus so-called glider, automobile, car, van, truck, motorcycle and/or limosine article, apparatus and/or megastructure innovation, engineering, design, development, accounting, reconciling, auditing, reporting, communicating, broadcasting, energizing, fueling, production, manufacturing, promotion, distribution, tracking, transporting and financing instrument matching, clearing, executing, settling and exchanging aforementioned UCMOST™ real-time processing and/or reprocessing of data and/or information inclusive of, without limitation, the following aforementioned PUBLIC FINANCIALS™ Porsche Motors; so-called BMW Motors; so-called Ford Motors; so-called General Motors; so-called Chrysler Motors; so-called Lexus Motors; so-called Delphi Automotive Systems; so-called Johnson Controls; so-called Pontiac Motors; so so-called PACCAR, so-called Nissan Motors; so-called Mitsubishi Motors; so-called Honda Motors; so-called KIA Motors; so-called Toyota Motors; so-called Champion Sparkplug Corp.; so-called Goodyear Tire Corp.; so-called Firestone Tire Corp.; inclusive of, without limitation, every and all of the following so-called electric, fuel and energy utilities distribution article, apparatus and/or megastructure innovation, engineering, design, development, accounting, reconciling, auditing, reporting, communicating, broadcasting, energizing, fueling, production, manufacturing, promotion, distribution, tracking, transporting and financing instrument matching, clearing, executing, settling and exchanging aforementioned UCMOST™ real-time processing and/or reprocessing of data and/or information inclusive of, without limitation, the following aforementioned PUBLIC FINANCIALS™ organizations: so-called Palo Alto Nuclear Energy Plant; so-called ExxonMobil Corp.; so-called Unocal; so-called Northern Edison; so-called Florida Power and Light Group; so-called Pacific Gas and Electric; so-called AES; so-called Duke Energy, so-called Souther; so-called Dominion Res; so-called Enron; so-called Amoco Corp.; so-called Chevron Corp.; so-called Royal Dutch Petroleum-Shell; so-called Phillips Petroleum Co.Gulf; so-called Texaco; so-called Citgo; so-called Coastal; so-called Hess; so-called Marathon; so-called Apache Corp.; Noric Corp.; so-called Newfield Exploration; so-called Pogo Producing; so-called Occidential Petroleum Corp; so-called Petrobras; so-called Mexicanas Petroleras; so-called Emerson Electric; so-called Rockwell International; so-called Cooper Indusries; so-called Williams Cos; so-called American Power Conversion; so-called Esso International; so-caled Turkey Point Energy Plant; inclusive of, without limitation, every and all of the following network access, member subscription, pay-per-view and/or pre-paid street, street walking, street theater, off-off-Broadway, off-Broadway, radio, television, cinema, cable and/or artificial satellite so-called new media broadcasting, distribution, syndication, rebroadlcasting, redistribution and/or resyndication article, apparatus and/or megastructure innovation, engineering, design, development, accounting, reconciling, auditing, reporting, communicating, exchanging aforementioned UCMOST™ real-time processing and/or reprocessing of data and/or information inclusive of, without limitation, the following aforementioned PUBLIC FINANCIALS™ organizations: so-called MSFT Ultimate TV; so-called American Broadcasting Company, so-called Company Broadcast Service; so-called National Broadcasting Company; so-called Fox Broadcasting Company; so-called Twenty-First Century Fox Motion Picture Company; so-called Castle Rock Motion Picture Company; so-called Columbia TriStar Motion Picture Company; so-called Turner Broadcasting Stations; so-called Cable News Network; so-called Paxson Communications; so-called BET; so-called UPN; so-called Public Broadcasting Service; so-called DirectTV; so-called Viacom, Inc.; so-called Liberty Mutal Group; so-called TiVo; so-called Home Box Office; so-called Cinemax; so-called Showtime; so-called Paramount Studios Movie Pictures; so-called Universal Studios Movie Pictures; so-called Warner Brothers Studios Movie Pictures; so-called MGM Movie Pictures; so-called Twenty-First Century Fox Movie Pictures; so-called TouchStone Movie Pictures; so-called AT&T-MediaOne; so-called RealNetworks-RealPlayer; so-called Microsoft Windows-Media Player; so-called Apple Computer-QuickTime; so-called Merril Lynch & Co.-Streaming Media; so-called iBeam Broadcasting; so-called Blockbuster Video; so-called National Public Radio; so-called Motion Picture Association of America; so-called National Association of Performing Artists; so-called Moving Pictures Experts Group; so-called Recording Industry Association; so-called National Cable Television Association; so-called Radio One; so-called Hispanic Broadcasting; so-called Univision; so-called Galavision; so-called Spanish Broadcasting; so-called Univision; so-called Clear Channel Communications; so-called Sirius Company; so-called XM; so-called DreamCast SKG; so-called Charter Communications; inclusive of, without limitation, every and all of the following so-called recreational, leisure and entertainment sporting and/or gaming center, convention, arena, ship, stadium, horsetrack and/or racetrack article, apparatus and/or megastructure innovation, engineering, design, development, accounting, reconciling, auditing, reporting, communicating, broadcasting, energizing, fueling, production, manufacturing, promotion, distribution, tracking, transporting and financing instrument matching, clearing, executing, settling and exchanging aforementioned UCMOST™ real-called National Football League (NFL); so-called Major League Baseball (MLB); so-called National Basketball Association (NBA); so-called Major League Hockey Association (MLH); so-called Major League Soccer Association (MLS); so-called College Football Association (CFA); so-called College Baseball Association (CBA); so-called College Athletic Sports Associations (CASA); so-called High School Athletic Sports Associations (HASA); so-called Canadian Football League (CFL); so-called Canadian Basketball Association (CBA); so-called World Boxing Association (WBA); so-called International Boxing Federation (IFB); so-called International Racehorsing Sport Association (IRSA); so-called Casino Gaming International Federation (CGIF); so-called National Association of Stock Combustible Automobile Racecars (NASCAR); so-called International Motorsports Speedway Associations; so-called International Motorcycle Association (IMA); so-called United States Tennis Association (USTA); so-called International Tennis Associations; so-called Professional Golfing Association (PGA); so-called International Golfing Associations (IGA); so-called International Winter and/or Summer Olympic Games (IOG); inclusive of, without limitation, every and all of the following heretofore so-called venture capital article, apparatus and/or megastructure innovation, engineering, design, development, accounting, reconciling, auditing, reporting, communicating, broadcasting, energizing, fueling, production, manufacturing, promotion, distribution, tracking, transporting and financing instrument matching, clearing, executing, settling and exchanging aforementioned UCMOST™ real-time processing and/or reprocessing of data and/or information inclusive of, without limitation, the following aforementioned PUBLIC FINANCIALS™ organizations: so-called Vulcan Ventures, Inc.; so-called Benchmark Capital; so-called Accel Partners; so-called Kleiner, Perkins, Caufield and Byers; so-called Redpoint Ventures; so-called Reuters Greenhouse Venture Group; so-called Angel Investors; so-called Lucent Venture Partners; so-called Arthur Andersen Venture Group; so-called SoftBank Venture Group; so-called US Venture Partners; inclusive of, without limitation, every and all of the following so-called information technology and/or so-called information technical consulting article, apparatus and/or megastructure innovation, engineering, design, development, accounting, reconciling, auditing, reporting, communicating, broadcasting, energizing, fueling, UCMOST™ real-time processing and/or reprocessing of data and/or information inclusive of, without limitation, the following aforementioned PUBLIC FINANCIALS™ organizations: so-called Accenture; so-called Arthur Andersen, LLP; so-called Ernst & Young, LLP; so-called KPMG Consulting, Inc.; so-called PriceWaterhouseCoopers, LLP; so-called Deloitte & Touch, LLP; so-called AON Risk Management; so-called Baker McKenzie; so-called Marsh & McLennan; so-called International Business Machines; so-called AOL Time Warner; so-called CMGI; so-called Oracle Corporation; so-called Veritas Software; so-called Quicken; so-called Sun MicroSystems; so-called Novell; so-called The Open Group; so-called Linux Open-Source; so-called Red Hat, Inc.; so-called Unysis; so-called Computer Associates International, Inc.; so-called Seibel Systems, Inc.; so-called Sabre Systems; so-called JD Edwards; so-called Microsoft Corporation; every and all above, without limitation, hereto considered, included, recognized, identified, acknowledged, and apprehended as undeniably, evidentiary, logically, scientifically and intuitively aforementioned PUBLIC FINANCIALS™ organizations; inclusive of, without limitation, every and all of the following below obfuscating so-called free and veiled predatory, vexing, portentous, pretentious, predatory, carinvorous and raptorial network access, member subscription, pay-per-view and/or pre-paid street, street walking, street theater, off-off-Broadway, off-Broadway, radio, television, cinema, cable and/or artificial satellite so-called media broadcasting, distribution, syndication, rebroadlcasting, redistribution and/or resyndication article, apparatus and/or megastructure innovation, engineering, design, development, accounting, reconciling, auditing, reporting, communicating, broadcasting, energizing, fueling, production, manufacturing, promotion, distribution, tracking, transporting and financing instrument matching, clearing, executing, settling and exchanging aforementioned UCMOST™ real-time processing and/or reprocessing of data and/or information involving aforementioned PUBLIC FINANCIALS™ organizations: whichever so-called United States public newspaper, publication, radio, televison, cinema, cable and/or artificial satellite broadcast communications media stations; whichever so-called Canadian public newspaper, publication, radio, televison, cinema, cable and/or artificial satellite broadcast communications media stations; whichever so-called United Kindgom public newspaper, publication, radio, televison, cinema, cable and/or artificial satellite broadcast communications media stations; whichever so-called EuroPan public newspaper, publication, radio, televison, cinema, cable and/or artificial satellite broadcast communications media stations; whichever so-called IberoPan American public newspaper, publication, radio, televison, cinema, cable and/or artificial satellite broadcast communications media stations; whichever so-called Siberian public newspaper, publication, radio, televison, cinema, cable and/or artificial satellite broadcast communications media stations; whichever so-called Germany public newspaper, publication, radio, televison, cinema, cable and/or artificial satellite broadcast communications media stations; whichever so-called France public newspaper, publication, radio, televison, cinema, cable and/or artificial satellite broadcast communications media stations; whichever so-called Spain public newspaper, publication, radio, televison, cinema, cable and/or artificial satellite broadcast communications media stations; whichever so-called Italian public newspaper, publication, radio, televison, cinema, cable and/or artificial satellite broadcast communications media stations; whichever so-called Switzerland public newspaper, publication, radio, televison, cinema, cable and/or artificial satellite broadcast communications media stations; whichever so-called United Arab Emirates public newspaper, publication, radio, televison, cinema, cable and/or artificial satellite broadcast communications media stations; whichever so-called Norway public newspaper, publication, radio, televison, cinema, cable and/or artificial satellite broadcast communications media stations; whichever so-called Netherlands public newspaper, publication, radio, televison, cinema, cable and/or artificial satellite broadcast communications media stations; whichever so-called Iceland public newspaper, publication, radio, televison, cinema, cable and/or artificial satellite broadcast communications media stations; whichever so-called New Zealand public newspaper, publication, radio, televison, cinema, cable and/or artificial satellite broadcast communications media stations; whichever so-called Denmark public newspaper, publication, radio, televison, cinema, cable and/or artificial satellite broadcast communications media stations; whichever so-called Finland public newspaper, publication, radio, televison, cinema, cable and/or artificial satellite broadcast communications media stations; whichever so-called Morocco public newspaper, publication, radio, televison, cinema, cable and/or artificial satellite broadcast communications media stations, whichever so-called Liechtenstein public newspaper, publication, radio, televison, cinema, cable and/or artificial satellite broadcast communications media stations; whichever so-called Liechtenstein public newspaper, publication, radio, televison, cinema, cable and/or artificial satellite broadcast communications media stations; whichever so-called Sweden public newspaper, publication, radio, televison, cinema, cable and/or artificial satellite broadcast communications media stations; whichever so-called Bulgaria public newspaper, publication, radio, televison, cinema, cable and/or artificial satellite broadcast communications media stations; whichever so-called Japan public newspaper, publication, radio, televison, cinema, cable and/or artificial satellite broadcast communications media stations; whichever so-called Taiwan public newspaper, publication, radio, televison, cinema, cable and/or artificial satellite broadcast communications media stations; whichever so-called Vietnam public newspaper, publication, radio, televison, cinema, cable and/or artificial satellite broadcast communications media stations; whichever so-called Thailand public newspaper, publication, radio, televison, cinema, cable and/or artificial satellite broadcast communications media stations; whichever so-called Singapore public newspaper, publication, radio, televison, cinema, cable and/or artificial satellite broadcast communications media stations; whichever so-called Brazil public newspaper, publication, radio, televison, cinema, cable and/or artificial satellite broadcast communications media stations; whichever so-called Chile public newspaper, publication, radio, televison, cinema, cable and/or artificial satellite broadcast communications media stations; whichever so-called Argentina public newspaper, publication, radio, televison, cinema, cable and/or artificial satellite broadcast communications media stations; whichever so-called Mexico public newspaper, publication, radio, televison, cinema, cable and/or artificial satellite broadcast communications media stations; whichever so-called Columbian public newspaper, publication, radio, televison, cinema, cable and/or artificial satellite broadcast communications media stations; whichever so-called Bolivia public newspaper, publication, radio, televison, cinema, cable and/or artificial satellite broadcast communications media stations; whichever so-called Panama public newspaper, publication, radio, televison, cinema, cable and/or artificial satellite broadcast communications media stations; whichever so-called Paraguay public newspaper, publication, radio, televison, cinema, cable and/or artificial satellite broadcast communications media stations; whichever so-called Peru public newspaper, publication, radio, televison, cinema, cable and/or artificial satellite broadcast communications media stations; whichever so-called Venezuelan public newspaper, publication, radio, televison, cinema, cable and/or artificial satellite broadcast communications media stations; whichever so-called Trinidad and Tobago public newspaper, publication, radio, televison, cinema, cable and/or artificial satellite broadcast communications media stations; whichever so-called Caribbean Republics public newspaper, publication, radio, televison, cinema, cable and/or artificial satellite broadcast communications media stations; whichever so-called Greneda public newspaper, publication, radio, televison, cinema, cable and/or artificial satellite broadcast communications media stations; whichever so-called Costa Rica public newspaper, publication, radio, televison, cinema, cable and/or artificial satellite broadcast communications media stations; whichever so-called Dominican Republic public newspaper, publication, radio, televison, cinema, cable and/or artificial satellite broadcast communications media stations; whichever so-called Haiti Republic public newspaper, publication, radio, televison, cinema, cable and/or artificial satellite broadcast communications media stations; whichever so-called Holy See public newspaper, publication, radio, televison, cinema, cable and/or artificial satellite broadcast communications media stations; whichever so-called El Salvador public newspaper, publication, radio, televison, cinema, cable and/or artificial satellite broadcast communications media stations; whichever so-called Honduras public newspaper, publication, radio, televison, cinema, cable and/or artificial satellite broadcast communications media stations; whichever so-called Guatemala public newspaper, publication, radio, televison, cinema, cable and/or artificial satellite broadcast communications media stations; whichever so-called Antigua and Barbuda public newspaper, publication, radio, televison, cinema, cable and/or artificial satellite broadcast communications media stations; whichever so-called Jamaica public newspaper, publication, radio, televison, cinema, cable and/or artificial satellite broadcast communications media stations; whichever so-called Saint Kitts and Nevis public newspaper, publication, radio, televison, cinema, cable and/or artificial satellite broadcast communications media stations; whichever so-called San Marino public newspaper, publication, radio, televison, cinema, cable and/or artificial satellite broadcast communications media stations; whichever so-called Sierra Leone public newspaper, publication, radio, televison, cinema, cable and/or artificial satellite broadcast communications media stations; whichever so-called Barbados public newspaper, publication, radio, televison, cinema, cable and/or artificial satellite broadcast communications media stations; whichever so-called Central Caribbean public newspaper, publication, radio, televison, cinema, cable and/or artificial satellite broadcast communications media stations; whichever so-called Malaysia public newspaper, publication, radio, televison, cinema, cable and/or artificial satellite broadcast communications media stations; whichever so-called Malta public newspaper, publication, radio, televison, cinema, cable and/or artificial satellite broadcast communications media stations; whichever so-called Philippines public newspaper, publication, radio, televison, cinema, cable and/or artificial satellite broadcast communications media stations; whichever so-called Indonesia public newspaper, publication, radio, televison, cinema, cable and/or artificial satellite broadcast communications media stations; whichever so-called Srika public newspaper, publication, radio, televison, cinema, cable and/or artificial satellite broadcast communications media stations; whichever so-called Tunisia public newspaper, publication, radio, televison, cinema, cable and/or artificial satellite broadcast communications media stations; whichever so-called Korea public newspaper, publication, radio, televison, cinema, cable and/or artificial satellite broadcast communications media stations; whichever so-called Tokyo public newspaper, publication, radio, televison, cinema, cable and/or artificial satellite broadcast communications media stations; whichever so-called Turkey public newspaper, publication, radio, televison, cinema, cable and/or artificial satellite broadcast communications media stations; whichever so-called Greece public newspaper, publication, radio, televison, cinema, cable and/or artificial satellite broadcast communications media stations; whichever so-called Cyprus public publication, radio, televison, cinema, cable and/or artificial satellite broadcast communications media stations; whichever so-called African public newspaper, publication, radio, televison, cinema, cable and/or artificial satellite broadcast communications media stations; whichever so-called Ghana public newspaper, publication, radio, televison, cinema, cable and/or artificial satellite broadcast communications media stations; whichever so-called Kenya public newspaper, publication, radio, televison, cinema, cable and/or artificial satellite broadcast communications media stations; whichever so-called Malawi public newspaper, publication, radio, televison, cinema, cable and/or artificial satellite broadcast communications media stations; whichever so-called Sudan public newspaper, publication, radio, televison, cinema, cable and/or artificial satellite broadcast communications media stations; whichever so-called Gambia public newspaper, publication, radio, televison, cinema, cable and/or artificial satellite broadcast communications media stations; whichever so-called Suriname public newspaper, publication, radio, televison, cinema, cable and/or artificial satellite broadcast communications media stations; whichever so-called Swaziland public newspaper, publication, radio, televison, cinema, cable and/or artificial satellite broadcast communications media stations; whichever so-called Uganda public newspaper, publication, radio, televison, cinema, cable and/or artificial satellite broadcast communications media stations; whichever so-called Benin public newspaper, publication, radio, televison, cinema, cable and/or artificial satellite broadcast communications media stations; whichever so-called Burkina Faso public newspaper, publication, radio, televison, cinema, cable and/or artificial satellite broadcast communications media stations; whichever so-called Burundi public newspaper, publication, radio, televison, cinema, cable and/or artificial satellite broadcast communications media stations; whichever so-called Cameroon public newspaper, publication, radio, televison, cinema, cable and/or artificial satellite broadcast communications media stations; whichever so-called Central African public newspaper, publication, radio, televison, cinema, cable and/or artificial satellite broadcast communications media stations; whichever so-called Chad public newspaper, publication, radio, televison, cinema, cable and/or artificial satellite broadcast communications media whichever so-called Cote d'Ivoire public newspaper, publication, radio, televison, cinema, cable and/or artificial satellite broadcast communications media stations; whichever so-called Gabon public newspaper, publication, radio, televison, cinema, cable and/or artificial satellite broadcast communications media stations; whichever so-called Guinea public newspaper, publication, radio, televison, cinema, cable and/or artificial satellite broadcast communications media stations; whichever so-called Mali public newspaper, publication, radio, televison, cinema, cable and/or artificial satellite broadcast communications media stations; whichever so-called Mauritania public newspaper, publication, radio, televison, cinema, cable and/or artificial satellite broadcast communications media stations; whichever so-called Mauritius public newspaper, publication, radio, televison, cinema, cable and/or artificial satellite broadcast communications media stations; whichever so-called Moldavia public newspaper, publication, radio, televison, cinema, cable and/or artificial satellite broadcast communications media stations; whichever so-called Moldoro public newspaper, publication, radio, televison, cinema, cable and/or artificial satellite broadcast communications media stations; whichever so-called Mongolia public newspaper, publication, radio, televison, cinema, cable and/or artificial satellite broadcast communications media stations; whichever so-called Nigeria public newspaper, publication, radio, televison, cinema, cable and/or artificial satellite broadcast communications media stations; whichever so-called Senegal public newspaper, publication, radio, televison, cinema, cable and/or artificial satellite broadcast communications media stations; whichever so-called Niger public newspaper, publication, radio, televison, cinema, cable and/or artificial satellite broadcast communications media stations; whichever so-called Togo public newspaper, publication, radio, televison, cinema, cable and/or artificial satellite broadcast communications media stations; whichever so-called Estonia public newspaper, publication, radio, televison, cinema, cable and/or artificial satellite broadcast communications media stations; whichever so-called Rwanda public newspaper, publication, radio, televison, cinema, cable and/or artificial satellite broadcast communications media stations; whichever so-called Ethiopia public newspaper, publication, radio, televison, cinema, cable and/or artificial satellite broadcast communications media stations; whichever so-called Guyana public newspaper, publication, radio, televison, cinema, cable and/or artificial satellite broadcast communications media stations; whichever so-called Algeria public newspaper, publication, radio, televison, cinema, cable and/or artificial satellite broadcast communications media stations; whichever so-called Zaire public newspaper, publication, radio, televison, cinema, cable and/or artificial satellite broadcast communications media stations; whichever so-called Zambia public newspaper, publication, radio, televison, cinema, cable and/or artificial satellite broadcast communications media stations; whichever so-called Zimbabwe public newspaper, publication, radio, televison, cinema, cable and/or artificial satellite broadcast communications media stations; whichever so-called South Africa public newspaper, publication, radio, televison, cinema, cable and/or artificial satellite broadcast communications media stations; whichever so-called Albania public newspaper, publication, radio, televison, cinema, cable and/or artificial satellite broadcast communications media stations; whichever so-called Buinea-Bissau public newspaper, publication, radio, televison, cinema, cable and/or artificial satellite broadcast communications media stations; whichever so-called Armenia public newspaper, publication, radio, televison, cinema, cable and/or artificial satellite broadcast communications media stations; whichever so-called Azebaijan public newspaper, publication, radio, televison, cinema, cable and/or artificial satellite broadcast communications media stations; whichever so-called Bangladesh public newspaper, publication, radio, televison, cinema, cable and/or artificial satellite broadcast communications media stations; whichever so-called Belarus public newspaper, publication, radio, televison, cinema, cable and/or artificial satellite broadcast communications media stations; whichever so-called Belgium public newspaper, publication, radio, televison, cinema, cable and/or artificial satellite broadcast communications media stations; whichever so-called Syria public newspaper, publication, radio, televison, cinema, cable and/or artificial satellite broadcast communications media stations; whichever so-called Egypt public newspaper, publication, radio, televison, cinema, cable and/or artificial satellite broadcast communications media stations; whichever so-called Kuwait public newspaper, publication, radio, televison, cinema, cable and/or artificial satellite broadcast communications media stations; whichever so-called newspaper, publication, radio, televison, cinema, cable and/or artificial satellite broadcast communications media stations; whichever so-called India public newspaper, publication, radio, televison, cinema, cable and/or artificial satellite broadcast communications media stations; whichever so-called Middle-PanEast public newspaper, publication, radio, televison, cinema, cable and/or artificial satellite broadcast communications media stations; whichever so-called Lebanon public newspaper, publication, radio, televison, cinema, cable and/or artificial satellite broadcast communications media stations; whichever so-called Lesotho public newspaper, publication, radio, televison, cinema, cable and/or artificial satellite broadcast communications media stations; whichever so-called Iran public newspaper, publication, radio, televison, cinema, cable and/or artificial satellite broadcast communications media stations; whichever so-called Pakistan public newspaper, publication, radio, televison, cinema, cable and/or artificial satellite broadcast communications media stations, whichever so-called Iraq Public; whichever so-called Kyrgyzstan public newspaper, publication, radio, televison, cinema, cable and/or artificial satellite broadcast communications media stations; whichever so-called Latvia public newspaper, publication, radio, televison, cinema, cable and/or artificial satellite broadcast communications media stations; whichever so-called Kazakhstan public newspaper, publication, radio, televison, cinema, cable and/or artificial satellite broadcast communications media stations; whichever so-called Tajikistan public newspaper, publication, radio, televison, cinema, cable and/or artificial satellite broadcast communications media stations; whichever so-called Tanzania public newspaper, publication, radio, televison, cinema, cable and/or artificial satellite broadcast communications media stations; whichever so-called Georgia public newspaper, publication, radio, televison, cinema, cable and/or artificial satellite broadcast communications media stations; whichever so-called Croatia public newspaper, publication, radio, televison, cinema, cable and/or artificial satellite broadcast communications media stations; whichever so-called Ukraine public newspaper, publication, radio, televison, cinema, cable and/or artificial satellite broadcast communications media stations; whichever so-called Czech public newspaper, publication, radio, televison, cinema, cable and/or artificial satellite broadcast communications media whichever so-called Scompassionnia public newspaper, publication, radio, televison, cinema, cable and/or artificial satellite broadcast communications media stations; whichever so-called Uzbekistan public newspaper, publication, radio, televison, cinema, cable and/or artificial satellite broadcast communications media stations; whichever so-called Lithuani public newspaper, publication, radio, televison, cinema, cable and/or artificial satellite broadcast communications media stations; whichever so-called Macedonia public newspaper, publication, radio, televison, cinema, cable and/or artificial satellite broadcast communications media stations; whichever so-called Turkmenistan public newspaper, publication, radio, televison, cinema, cable and/or artificial satellite broadcast communications media stations; whichever so-called Slovak Republic public newspaper, publication, radio, televison, cinema, cable and/or artificial satellite broadcast communications media stations; whichever so-called Madagascar public newspaper, publication, radio, televison, cinema, cable and/or artificial satellite broadcast communications media stations; whichever so-called Yugoslavia public newspaper, publication, radio, televison, cinema, cable and/or artificial satellite broadcast communications media stations; whichever so-called Romania public newspaper, publication, radio, televison, cinema, cable and/or artificial satellite broadcast communications media stations; whichever so-called Poland public newspaper, publication, radio, televison, cinema, cable and/or artificial satellite broadcast communications media stations; whichever so-called Liberia public newspaper, publication, radio, televison, cinema, cable and/or artificial satellite broadcast communications media stations; whichever so-called Bosnia-Herzegovina public newspaper, publication, radio, televison, cinema, cable and/or artificial satellite broadcast communications media stations; whichever so-called Russia public newspaper, publication, radio, televison, cinema, cable and/or artificial satellite broadcast communications media stations; whichever so-called China public newspaper, publication, radio, televison, cinema, cable and/or artificial satellite broadcast communications media stations; whichever so-called Cuba public newspaper, publication, radio, televison, cinema, cable and/or artificial satellite broadcast communications media stations; every and all above, without limitation, hereto considered, included, recognized, identified, is a clear and undeniable findings of fact, documented reference, logical scientific deduction and intutive analytical reasoning that invoked within aforementioned UCMOST™ information technology is comprehensively suitable, generally pertient and broadly useful entailing, encompassing, comprising, involving, impacting and/or effecting every and all hereto members of the aforementioned UNIVERSAL POPULACE™ targeting whichever elective and appointed executive, legislative, judicial, regulatory, management, administrative, operational and functional positions, commissions, sessions, cabinets, committees, forums and/or consortiums wherefrom derived members of the aforementioned UNIVERSAL POPULACE™ are inclusive of, without limitation, every and all of the following; public elective and appointed executive; public elective and appointed legislative; public elective and appointed judicial; public elective and municipal rescue affair operatives, military performances, overt programs, illegal covert initiatives, schemes, ocurrences, happenings, interactions, processes, methods, practices, movements, proceedings, messaging, presentations, notifications, filings, submissions, records, activities, actions, events, endeavors, tasks and affairs, diplomatic envoy, sovereign directives, legislative constructions, constitutional developments, national municipals, bi-laterial treaties, transnational accords and/or multinational governance convention dealings: public elective and appointed military affairs; public elective and appointed commerce and trade; public elective and appointed labor and work productivity, public elective and appointed attorney generals; public elective and appointed communications; public elective and appointed consumer service; public elective and appointed securities; public elective and appointed banking; public elective and appointed insurance; public elective and appointed customs air, d and sea access way; public elective and appointed energy and fuel utilities; public elective and appointed agriculture; public elective and appointed health services; public elective and appointed food and poultry; public elective and appointed pharaceutical drug; public elective and appointed water and sewer; public elective and appointed aerospace and aeronautical; public elective and appointed child welfare and endangerrment; public elective and appointed consumer goods; public elective and appointed consumer products; public elective and appointed consumer services; public elective and appointed rehabilitation and correctional; public elective and and appointed mayor governance; wherefrom every and all, without limitation, are respectively, independently, autonomously, evidently, undeniably, logically, scientifically and intuitively found to necessarily entail encompass, comprise, involve, impact and/or effect every and all of the heretofore completely unresolved tremendously long-held and enormously heart-felt unmet needs in the relevant art whichever in dire need of philosophical, practical and technical knowledge of every and all aspects, topics, issues, matters, elements, components, functions, processess, procedures, designs, systems, devices, forms, factors, ways, parts, segments, methods, combinations, know-how, ideas, art forms, articles of manufacture, discoveries, formulae, and architectural engineering of streamlined procedural computing process design compositions, whereform whereever and whichever heretofore not discovered wherefrom clearly evincing heretofore harming, damaging, inuring, insistent, insinuating, imposing, pestilent, impetuous, importune, pestiferous, condescending and insolent enthralling, hindering, entrapping, pretending, miring, fatiguing, maleficience, harassing, engulfing, pressing, malevolent, presuming, imprinting, malicious, suffocating, miring, strangling, repressing, entangling, pestering and oppressing members of the aforementioned UNIVERSAL POPULACE™ within the ancient history fragmenting market inefficiencies, wherefrom further hereto hertofore, present and hereafter every and all members of the aforementioned UNIVERSAL POPULACE™ are hereto discovered to be necessarily and increasingly integral withwithin a capital market entailing, encompassing, comprising, involving, impacting and/or effecting every and all whichever human beings and geographical sovereign territorial entities, wherefrom wherever and whichever utilizing antiquated, archaic, ancient history and superannuated and presently licensed market exchanges in existence residing and/or operating within domestic and/or transnational territories anywhere, anytime and anyplace within, throughout and transcending a single holistically econometric marketplace environment, wherefrom hereto but for the multifaceted and multidimensional transcending unequivocal absolute resolution invoked within aforementioned UCMOST™ information technology whose innate aim, letter, nature, breadth, sound, depth, spirit and scope is comprehensively suitable, generally pertinent and broadly useful as a panacean cutting-edge technological innovation inducing across-the-board traversal of every and all hereto encompassing, comprising, involving, impacting and/or effecting every and all broadcasting, distributing and/or syndicating transmission inclusive of every and all rebroadcasting, redistributing and/or resyndicating transmission throughout a single holistically econometric marketplace environment herewith undeniably, logically, referenced, scientificaly, intuitively and innovatively founds a concretizing efficient, effective, consolidated and integrated UNIVERSAL CAPITAL MARKET™, wherefrom hereto collectively innate conception, terminological conveyance, indivisible rubric, syntactic oralformulaic, unique artwork, systematic arrangement, differentiated crafting, artistic construct, melodious lyrics, denominative literateness and thereat proprietary multiport revolving chambered binary hunting metallic track encasing hermetic lock up cast casing constrained unified real-time microprocessor machine language object block keyhole combinational software computer code heretofore and hereafter apprehends efficient UNIVERSAL CAPITAL MARKET™, proprietary trademark and service mark is exclusive proprietary intellectual property belonging exclusively and unequivocally to Juan Carlos Castro. The founding actualization of the aforementioned efficient UNIVERSAL CAPITAL MARKET™ in streamlined fashion seamlessly and naturally transcends every and all multifaceted ways of life, education, work and recreation inclusive of, without limitation, every and all multidimensional industries and sectors and global commerce and trade within every and all necessarily integrated, critically important and increasingly integral national sovereign borders of every and all of the industrialized, developed and developing free-market commerce and trade bloc economies whichever wherefrom hereto terminological denominate a efficient, effective, consolidated and integrated UNIVERSAL ECONOMY™, wherefrom further hereto collectively innate conception, terminological conveyance, indivisible rubric, syntactic oralformulaic, unique artwork, systematic arrangement, differentiated crafting, artistic construct, melodious lyrics, denominative literateness and thereat proprietary multiport revolving chambered binary hunting metallic track encasing hermetic lock up cast casing constrained unified real-time microprocessor machine language object block keyhole combinational software computer code heretofore and hereafter apprehends efficient UNIVERSAL ECONOMY™, proprietary trademark and service mark is exclusive proprietary intellectual property belonging exclusively and transcendent aforementioned efficient UNIVERSAL ECONOMY™ is exclusively realizable via invoked within aforementioned UCMOST™ information technology which herewith literarily, melioristic logical positivismally, melodiously and artistically found to be necessarily, undeniably, logically, scientifically and intuitively comprehensively suitable, generally pertinent and broadly useful to concretize every and all Fill disclosure, best practices, best executions, enhance fairness, simultaneous equality, full transparency, consolidated access and perpetual integration of every and all of the aforementioned distinctively separate and traditionally exclusive speciality areas propagating ancient history and present public accounting, transport reconciling, independent auditing and financial reporting inclusive of the distincitvely separate and traditionally exclusive speciality areas propagating ancient history and present order-entry quotation, matching, clearance, settlement and exchange of insurance, risk financing, credit, cash management, investment banking and aforementioned PUBLIC FINANCIALS™ instruments within the aforementioned ancient history UNIVERSAL CAPITAL MARKET™ while it is undeniably, logically, scientifically and intuitively necessary to concretize formation and establishment of a new theater of operations and higher standards of public accounting, transport reonciliation, independent auditing and financial reporting seamlessly and naturally wrapped, twisted, convoluted and combined with order-entry quotation, matching, clearance, settlement and exchange of insurance, risk financing, credit, cash management, investment banking and aforementioned PUBLIC FINANCIALS™ instrument within an aforementioned efficient UNIVERSAL CAPITAL MARKET™ to further concretize an necessarily integrated, critically important and increasingly integral aforementioned efficient UNIVERSAL ECONOMY™, whereform moreover herewith is seamlessly and naturally traversed and therefrom concretizing respectively, independently, autonomously, evidently, undeniably, logically, scientifically and intuitively via streamlined, alternating scale, inseparable, seamless and natural wrapping, interlacing, coiling, coupling, combining and interlocking every and all techniques, designs, systems, routines, devices, manners, modes, fashions, forms, formats, factors, objects, parts, segments, elements, components, constituents, ingredients, processes, methods and combinations to realize factual integrated closed circuitry automatizing real-time holistically steady state synchronized ubiquitous and aforementioned PUBLIC FINANCIALS™ instruments transactional exchange initiatives, schemes, ocurrences, happenings, interactions, processes, methods, practices, movements, proceedings, messaging, presentations, notifications, filings, submissions, records, activities, actions, events, endeavors, tasks and affairs. Wherefrom further hereto actualizing optimized and efficient transport flow of every and all real-time processing and/or reprocessing of data and/or information receiver propagating via integrated closed circuitry automatizing real-time holistically steady state synchronized ubiquitous continuum real-time rhombus microprocessing instantaneous transmission and receiver transforming traverse conduit aforementioned UCMOST™ real-time processing and/or reprocessing of every and all aforementioned PUBLIC FINANCIALS™ instruments combining and interlocking every and all aforementioned PUBLIC FINANCIALS™ statements, resepectively recognized and addressed wherefrom hereto completely resolved as collectively innate conception, terminological conveyance, indivisible rubric, syntactic oralformulaic, unique artwork, systematic arrangement, differentiated crafting, artistic construct, melodious lyrics, denominative literateness and thereat proprietary multiport revolving chambered binary hunting metallic track encasing hermetic lock up cast casing constrained unified real-time microprocessor machine language object block keyhole combinational software computer code heretofore and hereafter apprehends invoked within aforementioned UCMOST™ information technology as comprehensively suitable, generally pertinent and broadly useful apparatus and device wherefrom hereto concretizes streamlined, alternating scale, inseparable, seamless and natural wrapping, interlacing, coiling, coupling, combining and interlocking wherefrom hereto with integrated closed circuitry automatizing real-time holistically steady state synchronized ubiquitous continuum real-time rhombus microprocessing instantaneous transmission and receiver transforming traverse conduit aforementioned UCMOST™ real-time processing and/or reprocessing of every and all of the distinctively separate and traditionally exclusive specialty areas entailing, encompassing, comprising, involving, impacting and/or effecting all ancient history and present techniques, designs, systems, routines, devices, manners, modes, fashions, forms, formats, factors, objects, parts, segments, elements, components, constituents, ingredients, processes, methods and combinations wherefrom hereto wherefrom further invoked within aforementioned UCMOST™ information technology as comprehensively suitable, generally pertinent and broadly useful to concretize streamlined, alternating scale, inseparable, seamless and natural wrapping, interlacing, coiling, coupling, combining and interlocking wherefrom hereto within integrated closed circuitry automatizing real-time holistically steady state synchronized ubiquitous continuum real-time rhombus microprocessing instantaneous transmission and receiver transforming traverse conduit aforementioned UCMOST™ real-time processing and/or reprocessing of every and all of the distinctively separate and traditionally exclusive specialty areas entailing, encompassing, comprising, involving, impacting and/or effecting all ancient history and present techniques, designs, systems, routines, devices, manners, modes, fashions, forms, formats, factors, objects, parts, segments, elements, components, constituents, ingredients, processes, methods and combinations wheretQm hereto actualizing streamlined order-entry quotation, clearance, execution, settlement, and exchange of insurance, risk financing, credit, cash management, investment banking and aforementioned PUBLIC FINANCIALS™ instruments. Wherefrom hereto the novel unobvious, unknown, unforeseen, unprecedented, epoch, paper-less, ease of use, fruitful, opportune, never faltering and never failing panacean cutting-edge utility technological engineering and architectural design of products and sevices invoking unequivocal absolute resolution of the tremendously long-held and enormously heart-felt unmet needs in the relevant art via aforementioned UCMOST™ information technology wherefrom hereto is further comprehensively suitable, generally pertinent and broadly useful to every and all integrated multifaceted and multidimensional useful capacities, technological manufacturing viabilities and commercial beneficial salabilities wherefrom hereto ensuring maximum capabilities to improve the tangbile numeric metric system precision and numeric metric system quality inclusive of the intangible honor and integrity whichever entailing, encompassing, comprising, involving, impacting and/or effecting every and all aforementioned PUBLIC FINANCIALS™ instruments which undeniably, logically, scientifically and intuitively derive every and all necessarily integrated, critically important and increasing integral aforementioned PUBLCI FINANCIALS statements wherefrom mitigating every and all comprehensively inappropriate, generally damaging and broadly commentaries, misleading statements, artifically inflated costing/pricing of products, goods, supplies and services, phantom invoice billings, illegitimate tax circumventions, undeniable, unnecessary, undeniable, unnecessary, unwarranted, illogical, unjustifiable, unreasoned and unmitigated, illogical, unjustifiable and unreasoned restatements, irrational exuberance, unsubstantiated uncertainties, unjustified speculations, revenue/earnings manipulations, improper utilization of asset reserves, imprudent off-balance sheet financing, manipulation of every and all real-time processing and/or reprocessing of data and/or information receiver, ignorant breach/threatened breach/infringement and/or malicious theft of every and all techniques, designs system routine; devices, manners, modes, fashions, forms, formats, factors, objects, parts, segments, elements, components, constituents, ingredients, processes, methods and combinations of inellectual property rights, titles, interests, entitlements and/or every and all legitimate claims to preferred embodiments inclusive of patent, copyrights trademark, trade-secret, and/or unfair, bad faith, malicious and/or predatory competition, and further ruthless, frigid and unjustifiable obstruction to every and all techniques, designs, systems, routines, devices, manners, modes, fashions, forms, formats, factors, objects, parts, segments, elements, components, constituents, ingredients, processes, methods and combinations of access to legislative congressional acts, statues, rules, regulations, venues and jurisidictions of every and all techniques designs, systems, routines, devices, manners, modes, fashions, forms, formats, factors, objects, parts, segments, elements, components, constituents, ingredients, processes, methods and combinations of general law, and illegitimate, frivolous, fabricated, misconstrued, phony, hoaxed, bogus and/or unsubstantiated lawsuits entailing, encompassing, comprising, involving, impacting and/or effecting every and all personal and members of the aforementioned UNIVERSAL POPULACE™ civil, penal, statutory and/or criminal legal claims, declarations, proceeedings, arbitrations, and mediations promulgated by untruthful, unlawful, self-serving, vulgar, anti-social, jealous, vengeful, unethical, immoral, unashamed, unscrupulous, unaccountable, uncomprehending, unfamiliar, unlettered, ignorant, untrained, unskilled, frigid, ruthless, distressed, distraught, disingenuous, disavowed, disbelieving, perverted and ultimately every and all techniques, designs, systems, routines, devices, manners, modes, fashions, forms, formats, factors, desires conceived out of greed from members of the aforementioned UNIVERSAL POPULACE™ propagating as individual beings and/or via class-action status whether or not ascertained commercially, personally and/or via assistance and/or guidance from legal counsel representatives, every and all techniques, designs, systems, routines, devices, manners, modes, fashions, forms, formats, factors, objects, parts, segments, elements, components, constituents, ingredients, processes, methods and combinations of legalized and/or illegal gaming initiatives, schemes, ocurrences, happenings, interactions, processes, methods, practices, movements, proceedings, messaging, presentations, notifications, filings, submissions, records, activities, actions, events, endeavors, tasks and affairs whether via impersonal and/or personalized games, wheels, articles, tables and/or machines, and moreover every and all techniques, designs, systems, routines, devices, manners, modes, fashions, forms, formats, factors, objects, parts, segments, elements, components, constituents, ingredients, processes, methods and combinations of impudent, inopportune, misinformed and unsubstantiated advisories and/or consultations, and every and all techniques, designs, systems, routines, devices, manners, modes, fashions, forms, formats, factors, objects, parts, segments, elements, components, constituents, ingredients, processes, methods and combinations which, directly and/or indirectly, without limitation, occur, happen, happenstance and/or transpire individually and/or collectively, anywhere, anytime and anyplace within, throughout and transcending a single holistically econometric marketplace environment, and which directly and/or indirectly, involve occurence, happening, happenstance and/or transpiring, irrespective of whether effectuated individually and/or collectively, inclusive of, without limitation, any and/or all of the following: fraud; skimming; negligence; misleading; misguiding; antagonizing; highlighting; hiding; resisting; provoking; taunting; teasing; suffocating; suppressing; prebend; repressing; oppressing; choking; fighting; assaulting; beating; intimidating; sexualizing; vilifying; shadowing; phantom; representing; repudiating; strapping; entangling; condescending; conceiting; inquiring; hindering; entrapping; miring; fatiguing; saturating; exposing; incoherent; ambiguous; polling; inducing; speculating; insinuating; bragging; insulting; second-guessing; hoopla; aggrandizing; exaggerating; aggravating; agglomerating; hogtying; intimidating; brainwashing; tyrannizing; eradicating; classifying; categorizing; stratifying; profiling; segmenting; disproving; disapproving; discrediting; ruinous; deucing; tempestuous; detrimental; destructive; holding-up; trashing; stalking; detractive; toxic; destructive; static; diagnoses; devilling; devious; devising; antipathetic; misconstruing; convoluting; stubbing; slippage; sortieing; conditioning; conducing; leading; concealing; cloistering; conceding; compelling; devaluing; apathetic; bogus; boastful; unscrupulous; portentous, pretentious, malicious; precarious; unreadable; illegible, unreserved, unrealistic; unreasonable; unnatural; unholy; provacative; indecent; ungodly; obscene; immoral; lewd; lavish; unorganized; unintelligible; unnerving; tresspassing; irritating; senseless; scanty; subliminal; sensational; superfluous; scandalizing; disrespect; exaggerating; spotlighting; presumptuous; pretentious; pretified; imprudent; impudence; improper; alien; unworthy; undistinguished; inscrutable; inscriptive; insanitary; insanely; insectivorous; unmanly; hideosity; frightening; scaring; jaunting; unregistered; repugnant; enthralling; replicating; cloning; duplicating; portraying; reproducing; copying; portraying; reciting; reengineering; plagiarizing; stealing; scapegoating; cold calling; sales; selling; specializing; discounting; brazening; networking; schmoozing; shenanigan; prank; stifling; raping; scooping; skating; sheltering; washing; evading; secluding; chatting; highballing; high-rolling; shadowing; shading; shagginess; inattentive; intolerating; disrespecting; shafting; politicking; underlining; rambling; repetitive; repetend; filibustering; tipping; dirty linen; dirty pool; dirty tricks; traitoring; squealing; high treason; espionage; dirty words; cry off; juke; boxing; side-swiping; wreckless driving; speeding; braking; slowing; wire-tapping; audiovisual-recording; taping; slouching; comparing; tempting; deceiving; holding; scuffling; scruppling; freelancing; panhandling; hiking; collateralizing; mischief; miser; teasing; shirmishing; misgiving; lynching; mobing; knuckling; beheading, hanging; targeting; hireling; horrifying; jabbing; defaming; mishandling; misfeasance; misbelieving; misbranding; miscalling; miscasting; dismaying; disorienting; preying; disabiling; erasing; conspiring; bombing; murdering; killing; highjacking; snatching; marching; scripting; combatting; conflicting; dividing; partialities; warring; unionsim; fighting; disagreeing; scalping; reptilian; razing; depreciatory; depravity; deviatory; discoloring; disclaiming; divisive; dooming; diurnal; dissimillating; dissonant; black-balling; demoralizing; ball boying; ball girling; concubine; concupiscence; degrading; protesting; smashing; breaking; igniting; incinerating; clanking; moaning; avenging; vigilantism; scrounging; disparaging; defaming, scoring defacing; cloning; churning; chuckling; spitting; viewing; promiscuous; overpersuading; questioning; leveraging; dismissing; pardoning; reducing; pleading; disordering; obnoxious; overpressuring; overreactive; overrepresenting; unmitigated; ostentatious; inordinate; palliative; inoculate; inobservant; deceptive; scattered; sporadic; spotty, sporty; undone; underrepresented; selling short; cooking; unaccented, unarticulated; unassailable; unbecoming; unappealable; unassisted; subjugating; untruthful; coupling; wasteful; troublesome; irresolute; irresponsible; introversive; irreverent; irrational; circumventing; intimidating; intolerant; diverting; disharmonious; deviating; bolstering, running: loud: auctioning; shouting; pitting; screaming; screeching; scratching; yelling; blasting; boisterousness; superimposing; high watermarking; imprinting; bylining; headlining; call-in; vociferous; emulating; imitating bibulous; copying biographies; linking; trailing; marking; ventilating; coaxing; misguiding; gaming; misleading; voracious; distraining; dishonest; disheveling; disheartening; ticky-tacky; disgusting; disguising; undertrick; undertaking; underworld; underhanding; disgraceful; unthankful; dishonoring; disinforming; conniving; scheming; disingenuous; unmentionable; disillusioning; disjunctive; theatricalizing; distorting; disenfranchising; distilling; entrancing; waiting; holding; inhibiting; incapacitating; hesitancy; entrapping; abetting; baiting; teasing; attacking; tormenting; depriving; insulting; ridiculing; crucifying; humiliating; condemning; enticing; tempting; trapping; hiding; covering; veiling; luring; viewdata; chaining; coiling; cluttering; tricking; evading; entrenching; ensnaring; ensnarling; eluding; eloping; elliptic; elision; echoing; eclipsing; earmarking; earful; hellacious; hemming; hocus-pocus; hood-winking; hornswoggling; horselaugh; horse-opera; smirking; giggling; horse-trading; horseewhipping; horsily; hot-air; hotch-potch; hotheaded; housebreaking; howling; huckstering; huffing; hightailing; high-roading; huffiness; patronizing; bamboozling; snowing; snapping; pronouncing; presenting; featuring; marketing; viewfinder; advertising; pop art; allegory; illustration; depicting; newspeak; marking; epithet; marking; remarking; coloring; airing; venting; annoying; vexing; insolent; incognizant; condescending; inspecting, erratic; unsteady; undependable; instigating, separating; breaking; cheating; breaching; threatening; pressing; extorting; pilling; racketeering; trafficking; distributing; ingesting; escorting; pimping; pressuring; pressing; hooting; honking; hooking; backstabbing; slandering; spamming; slamming; dumping; gouging; discounting; allowing; rebating; infiltrating; inferring; refunding; inducing; sneaking; sponsoring; advocating; featuring; benefitting; campaigning; catapulting; championing; manipulating; returning; discoursing; chiding; conversing; impugning; prying; peeping; hacking; chaining; chafing; twisting mixing; intertwining; interfacing; releasing; leaking; spreading; faking; videotaping; counterfitting; audiotaping; lying; covering; obstructing; licking; jabbing; splattering; splitting; imputing; faulting; favoring; labeling; stigmatizing; classifying; categorizing; separating; extracting; downloading; intruding; extenuating; extemporizing; fuzzing; contriving; shooting; shamming; feigning; conning; fabricating; backsliding; badgering; convoluting; disgracing; harassing; uploading; conflicting; deceiving; pretending; confusing; abstruse; opaque; obfuscating; inveighing; inveigling; hiking; understating; inadvertence; inauthentic; vengeful; vindictive; vitriolic; vivifying; violent; victimizing; violating; vigilante; vigorous; viperous; yearning; begging; yawing; worming; tripping; clipping; tipsy; tizzy; titular; tactilely; tackily; histrionic, or otherwise uninspiring reality, musical, opera, play, drama, travesty, horror, tragedy, comedy, animation, action, pop art, porn, science-fiction and theatrical copious works of literary, theatrical, melodius, artistic, sporting, eductional, pleasure, recreational and entertainment entailing, encompassing, comprising, involving, impacting and/or effecting audio, video, voice, visual, graphic and/or images inclusive of every and all, without limitation, hereto members of the aforementioned UNIVERSAL POPULACE™ compositions, productions, performances, solicitations, promotions, commercials, advertisements, promulgations and/or propagations from, without limitation, every and all members of the aforementioned UNIVERSAL POPULACE™ herewith inclusive of, without limitation, every and all such members of the messaging, presentations, notifications, filings, submissions, records, activities, actions, events, endeavors, tasks and affairs which furthermore entail, encompass, comprise, involve, impact and/or effect every and all, without limitation, of the following: members of the aforementioned UNIVERSAL POPULACE™ campaigning; members of the aforementioned UNIVPERAL POPULACE™ benefitting; members of the aforementioned UNIVERSAL POPULACE™ funding; members of the aforementioned UNIVERSAL POPULACE™ catapulting; members of the aforementioned UNIVERSAL POPULACE™ cocktailing; members of the aforementioned UNIVERSAL POPULACE™ sponsoring; members of the aforementioned UNIVERSAL POPULACE™ championing; members of the aforementioned UNIVERSAL POPULACE™ promotions; members of the aforementioned UNIVERSAL POPULACE™ elective public voting; members of the aforementioned UNIVERSAL POPULACE™ elective absentee public voting; members of the aforementioned UNIVERSAL POPULACE™ conversing; members of the aforementioned UNIVERSAL POPULACE™ gathering; members of the aforementioned UNIVERSAL POPULACE™ newspapers; members of the aforementioned UNIVERSAL POPULACE™ magazines; members of the aforementioned UNIVERSAL POPULACE™ pop art; members of the aforementioned UNIVERSAL POPULACE™ publications; members of the aforementioned UNIVERSAL POPULACE™ editorials; members of the aforementioned UNIVERSAL POPULACE™ bylines; members of the aforementioned UNIVERSAL POPULACE™ headlines; members of the aforementioned UNIVERSAL POPULACE™ imprints; members of the aforementioned UNIVERSAL POPULACE™ artistries; members of the aforementioned UNIVERSAL POPULACE™ performances; members of the aforementioned UNIVERSAL POPULACE™ productions; members of the aforementioned UNIVERSAL POPULACE™ notifications; members of the aforementioned UNIVERSAL POPULACE™ proxies; members of the aforementioned UNIVERSAL POPULACE™ billings; members of the aforementioned UNIVERSAL POPULACE™ invoices; members of the aforementioned UNIVERSAL POPULACE™ mortgages; members of the aforementioned UNIVERSAL POPULACE™ mortgage rates; members of the aforementioned UNIVERSAL POPULACE™ leases; members of the aforementioned UNIVERSAL POPULACE™ lease rates; members of the aforementioned POPULACE™ loans; members of the aforementioned UNIVERSAL POPULACE™ treasuring rates; members of the aforementioned UNIVERSAL POPULACE™ utilities; members of the aforementioned UNIVERSAL POPULACE™ utility rates; members of the aforementioned UNIVERSAL POPULACE™ products; members of the aforementioned UNIVERSAL POPULACE™ product rates; members of the aforementioned UNIVERSAL POPULACE™ goods; members of the aforementioned UNIVERSAL POPULACE™ products; members of the aforementioned UNIVERSAL POPULACE™ services; members of the aforementioned UNIVERSAL POPULACE™ supplies; members of the aforementioned UNIVERSAL POPULACE™ engines; members of the aforementioned UNIVERSAL POPULACE™ wheels; members of the aforementioned UNIVERSAL POPULACE™ fuels; members of the aforementioned UNIVERSAL POPULACE™ energy; inclusive of, without limitation, every and all musical, opera, play, drama, travesty, horror, tragedy, comedy, animation, action, porn, science-fiction and/or theatrical copious works of literary, theatrical, melodius, artistic, sporting, eductional, pleasure, recreational and entertainment audio, video, voice, visual, graphic and/or image compositions, productions, performances, solicitations, promotions, commercials, advertisements, promulgations and/or propagations entailing, encompassing, comprising, involving, impacting and/or effecting, without limitation, every and all of the following media conduits: members of the aforementioned UNIVERSAL POPULACE™ street pilots; members of the aforementioned UNIVERSAL POPULACE™ street productions; members of the aforementioned UNIVERSAL POPULACE™ street programs, members of the aforementioned UNIVERSAL POPULACE™ street performances; members of the aforementioned UNIVERSAL POPULACE™ street documentaries; members of the aforementioned UNIVERSAL POPULACE™ street acts; members of the aforementioned UNIVERSAL POPULACE™ street plays; members of the aforementioned UNVERSAL POPULACE™ street sitcoms; members of the aforementioned UNIVERSAL POPULACE™ street shows; members of the aforementioned UNIVERSAL POPULACE™ street games; members of the aforementioned UNIVERSAL POPULACE™ street realities; members of the aforementioned UNIVERSAL POPULACE™ street presentations; members of the aforementioned UNIVERSAL POPULACE™ street screen programs; members of the aforementioned UNIVERSAL POPULACE™ street screen performances; members of the aforementioned UNIVERSAL POPULACE™ street screen documentaries; members of the aforementioned UNIVERSAL POPULACE™ street screen acts; members of the aforementioned UNIVERSAL POPULACE™ street screen plays; members of the aforementioned UNIVERSAL POPULACE™ street screen sitcoms; members of the aforementioned UNIVERSAL POPULACE™ street screen shows; members of the aforementioned UNIVERSAL POPULACE™ street screen games; members of the aforementioned UNIERSAL POPULACE™ street screen realities: members of the aforementioned UNIVERSAL POPULACE™ street screen presentations; members of the aforementioned UNIVERSAL POPULACE™ street screen stage pilots; members of the aforementioned UNIVERSAL POPULACE™ street screen stage productions; members of the aforementioned UNIVERSAL POPULACE™ street screen stage programs; members of the aforementioned UNIVERSAL POPULACE™ street screen stage performances; members of the aforementioned UNIVERSAL POPULACE™ street screen stage documentaries; members of the aforementioned UNIVERSAL POPULACE™ street screen stage acts; members of the aforementioned UNIVERSAL POPULACE™ street screen stage plays; members of the aforementioned UNIVERSAL POPULACE™ street screen stage sitcoms; members of the aforementioned UNIVERSAL POPULACE™ street screen stage shows; members of the aforementioned UNIVERSAL POPULACE™ street screen stage games; members of the aforementioned UNIVERSAL POPULACE™ street screen stage realities; members of the aforementioned UNIVERSAL POPULACE™ street screen stage presentations; members of the aforementioned UNIVERSAL POPULACE™ street screen stage show pilots; members of the aforementioned UNIVERSAL POPULACE™ street screen stage show productions; members of the aforementioned UNIVERSAL POPULACE™ street screen stage show programs; members of the aforementioned UNIVERSAL POPULACE™ street screen stage show performances; members of the aforementioned UNIVERSAL POPULACE™ street screen stage show documentaries; members of the aforementioned UNIVERSAL POPULACE™ street screen stage show acts; members of the aforementioned UNIVERSAL POPULACE™ UNIVERSAL POPULACE™ street screen stage show shows; members of the aforementioned UNIVERSAL POPULACE™ street screen stage show games; members of the aforementioned UNIVERSAL POPULACE™ street screen stage show realities; members of the aforementioned UNIVERSAL POPULACE™ street screen stage show presentations; members of the aforementioned UNIVERSAL POPULACE™ street walking pilots; members of the aforementioned UNIVERSAL POPULACE™ street walking productions; members of the aforementioned UNIVERSAL POPULACE™ street walking programs; members of the aforementioned UNIVERSAL POPULACE™ street walking performances; members of the aforementioned UNIVERSAL POPULACE™ street walking documentaries members of the aforementioned UNIVERSAL POPULACE™ street walking acts; members of the aforementioned UNIVERSAL POPULACE™ street walking plays; members of the aforementioned UNIVERSAL POPULACE™ street walking sitcoms; members of the aforementioned UNIVERSAL POPULACE™ street walking shows; members of the aforementioned UNIVERSAL POPULACE™ street walking games; members of the aforementioned UNIVERSAL POPULACE™ street walking realities; members of the aforementioned UNIVERSAL POPULACE™ street walking presentations; members of the aforementioned UNIVERSAL POPULACE™ street walking screen pilots; members of the aforementioned UNIVERSAL POPULACE™ street walking screen productions; members of the aforementioned UNIVERSAL POPULACE™ street walking screen programs; members of the aforementioned UNIVERSAL POPULACE™ street walking screen performances; members of the aforementioned UNIVERSAL POPULACE™ street walking screen documentaries; members of the aforementioned UNIVERSAL POPULACE™ street walking screen acts; members of the aforementioned UNIVERSAL POPULACE™ street walking screen plays; members of the aforementioned UNIVERSAL POPULACE™ street walking screen sitcoms; members of the aforementioned UNIVERSAL POPULACE™ street walking screen shows; members of the aforementioned UNIVERSAL POPULACE™ street walking screen games; members of the aforementioned UNIVERSAL POPULACE™ street walking screen realities; members of the aforementioned UNIVERSAL POPULACE™ street walking screen presentations; stage productions; members of the aforementioned UNIVERSAL POPULACE™ street walking screen stage programs; members of the aforementioned UNIVERSAL POPULACE™ street walking screen stage performances; members of the aforementioned UNIVERSAL POPULACE™ street walking screen stage documentaries; members of the aforementioned UNIVERSAL POPULACE™ street walking screen stage acts; members of the aforementioned UNIVERSAL POPULACE™ street walking screen stage plays; members of the aforementioned UNIVERSAL POPULACE™ street walking screen stage sitcoms; members of the aforementioned UNIVERSAL POPULACE™ street walking screen stage shows; members of the aforementioned UNIVERSAL POPULACE™ street walking screen stage games; members of the aforementioned UNIVERSAL POPULACE™ street walking screen stage realities; members of the aforementioned UNIVERSAL POPULACE™ street walking screen stage presentations; members of the aforementioned UNIVERSAL POPULACE™ street walking screen stage show pilots, members of the aforementioned UNIVERSAL POPULACE™ street walking screen stage show productions; members of the aforementioned UNIVERSAL POPULACE™ street walking screen stage show programs; members of the aforementioned UNIVERSAL POPULACE™ street walking screen stage show performances; members of the aforementioned UNIVERSAL POPULACE™ street walking screen stage show documentaries; members of the aforementioned UNIVERSAL POPULACE™ street walking screen stage show acts; members of the aforementioned UNIVERSAL POPULACE™ street walking screen stage show plays; members of the aforementioned UNIVERSAL POPULACE™ street walking screen stage show sitcoms; members of the aforementioned UNIVERSAL POPULACE™ street walking screen stage show shows; members of the aforementioned UNIVERSAL POPULACE™ street walking screen stage show games; members of the aforementioned UNIVERSAL POPULACE™ street walking screen stage show realities; members of the aforementioned UNIVERSAL POPULACE™ street walking screen stage show presentations; members of the aforementioned UNIVERSAL POPULACE™ street theater pilots; members of the aforementioned UNIVERSAL POPULACE™ street theater productions; members of the aforementioned UNIVERSAL POPULACE™ street theater programs; members of the aforementioned aforementioned UNIVERSAL POPULACE™ street theater acts; members of the aforementioned UNIVERSAL POPULACE™ street theater plays; members of the aforementioned UNIVERSAL POPULACE™ street theater sitcoms; members of the aforementioned UNIVERSAL POPULACE™ street theater shows; members of the aforementioned UNIVERSAL POPULACE™ street theater games; members of the aforementioned UNIVERSAL POPULACE™ street theater realities; members of the aforementioned UNIVERSAL POPULACE™ street theater presentations; members of the aforementioned UNIVERSAL POPULACE™ street theater screen pilots; members of the aforementioned UNIVERSAL POPULACE™ street theater screen productions; members of the aforementioned UNIVERSAL POPULACE™ street theater screen programs; members of the aforementioned UNIVERSAL POPULACE™ street theater screen performances; members of the aforementioned UNIVERSAL POPULACE™ street theater screen documentaries; members of the aforementioned UNIVERSAL POPULACE™ street theater screen acts; members of the aforementioned UNIVERSAL POPULACE™ street theater screen plays; members of the aforementioned UNIVERSAL POPULACE™ street theater screen sitcoms; members of the aforementioned UNIVERSAL POPULACE™ street theater screen shows; members of the aforementioned UNIVERSAL POPULACE™ street theater screen games; members of the aforementioned UNIVERSAL POPULACE™ street theater screen realities; members of the aforementioned UNIVERSAL POPULACE™ street theater screen presentations; members of the aforementioned UNIVERSAL POPULACE™ street theater screen stage pilots; members of the aforementioned UNIVERSAL POPULACE™ street theater screen stage productions: members of the aforementioned UNIVERSAL POPULACE™ street theater screen stage programs; members of the aforementioned UNIVERSAL POPULACE™ street theater screen stage performances; members of the aforementioned UNIVERSAL POPULACE™ street theater screen stage documentaries; members of the aforementioned UNIVERSAL POPULACE™ street theater screen stage acts; members of the aforementioned UNIVERSAL POPULACE™ street theater screen stage plays; members of the aforementioned UNIVERSAL POPULACE™ street theater screen stage sitcoms; members of the aforementioned UNIVERSAL POPULACE™ street theater screen stage screen stage realities; members of the aforementioned UNIVERSAL POPULACE™ street theater screen stage presentations; members of the aforementioned UNIVERSAL POPULACE™ street theater screen stage show pilots; members of the aforementioned UNIVERSAL POPULACE™ street theater screen stage show productions; members of the aforementioned UNIVERSAL POPULACE™ street theater screen stage show programs; members of the aforementioned UNIVERSAL POPULACE™ street theater screen stage show performances; members of the aforementioned UNIVERSAL POPULACE™ street theater screen stage show documentaries, members of the aforementioned UNIVERSAL POPULACE™ street theater screen stage show acts; members of the aforementioned UNIVERSAL POPULACE™ street theater screen stage show plays; members of the aforementioned UNIVERSAL POPULACE™ street theater screen stage show sitcoms; members of the aforementioned UNIVERSAL POPULACE™ street theater screen stage show shows; members of the aforementioned UNIVERSAL POPULACE™ street theater screen stage show games; members of the aforementioned UNIVERSAL POPULACE™ street theater screen stage show realities; members of the aforementioned UNIVERSAL POPULACE™ street theater screen stage show presentations; members of the aforementioned UNIVERSAL POPULACE™ off-off-Broadway pilots; members of the aforementioned UNIVERSAL POPULACE™ off-off-Broadway productions; members of the aforementioned UNIVERSAL POPULACE™ off-off-Broadway programs; members of the aforementioned UNIVERSAL POPULACE™ off-off-Broadway performances; members of the aforementioned UNIVERSAL POPULACE™ off-off-Broadway documentaries; members of the aforementioned UNIVERSAL POPULACE™ off-off-Broadwayacts; members of the aforementioned UNIVERSAL POPULACE™ off-off-Broadway plays; members of the aforementioned UNIVERSAL POPULACE™ off-off-Broadway sitcoms; members of the aforementioned UNIVERSAL POPULACE™ off-off-Broadway shows; members of the aforementioned UNIVERSAL POPULACE™ off-off-Broadway games; members of the aforementioned UNIVERSAL POPULACE™ off-off-Broadway realities; members of the aforementioned UNIVERSAL POPULACE™ off-off-Broadway presentations; members of the aforementioned UNIVERSAL POPULACE™ off-off-Broadway screen pilots; members of programs; members of the aforementioned UNIVERSAL POPULACE™ off-off-Broadway screen performances; members of the aforementioned UNIVERSAL POPULACE™ off-off-Broadway screen documentaries; members of the aforementioned UNIVERSAL POPULACE™ of-off-Broadway screen acts; members of the aforementioned UNIVERSAL POPULACE™ off-off-Broadway screen plays; members of the aforementioned UNIVERSAL POPULACE™ off-off-Broadway screen sitcoms; members of the aforementioned UNIVERSAL POPULACE™ off-off-Broadway screen shows; members of the aforementioned UNIVERSAL POPULACE™ off-off-Broadway screen games; members of the aforementioned UNIVERSAL POPULACE™ off-off-Broadway screen realities; members of the aforementioned UNIVERSAL POPULACE™ off-off-Broadway screen presentations; members of the aforementioned UNIVERSAL POPULACE™ off-off-Broadway screen stage pilots; members of the aforementioned UNIVERSAL POPULACE™ off-off-Broadway screen stage productions; members of the aforementioned UNIVERSAL POPULACE™ off-off-Broadway screen stage programs; members of the aforementioned UNIVERSAL POPULACE™ off-off-Broadway screen stage performances; members of the aforementioned UNIVERSAL POPULACE™ off-off-Broadway screen stage documentaries; members of the aforementioned UNIVERSAL POPULACE™ off-off-Broadway screen stage acts; members of the aforementioned UNIVERSAL POPULACE™ off-off-Broadway screen stage plays; members of the aforementioned UNIVERSAL POPULACE™ off-off-Broadway screen stage sitcoms; members of the aforementioned UNIVERSAL POPULACE™ off-off-Broadway screen stage shows; members of the aforementioned UNIVERSAL POPULACE™ off-off-Broadway screen stage games; members of the aforementioned UNIVERSAL POPULACE™ off-off-Broadway screen stage realities; members of the aforementioned UNIVERSAL POPULACE™ off-off-Broadway screen stage presentations; members of the aforementioned UNIVERSAL POPULACE™ off-off-Broadway screen stage show pilots; members of the aforementioned UNIVERSAL POPULACE™ off-off-Broadway screen stage show productions; members of the aforementioned UNIVERSAL POPULACE™ off-off-Broadway screen stage show programs; members of the aforementioned UNIVERSAL POPULACE™ off-off-Broadway screen stage show UNIVERSAL POPULACE™ off-off-Broadway screen stage show acts; members of the aforementioned UNIVERSAL POPULACE™ off-off-Broadway screen stage show plays; members of the aforementioned UNIVERSAL POPULACE™ off-off-Broadway screen stage show sitcoms; members of the aforementioned UNIVERSAL POPULACE™ off-off-Broadway screen stage show shows; members of the aforementioned UNIVERSAL POPULACE™ off-off-Broadway screen stage show games; members of the aforementioned UNIVERSAL POPULACE™ off-off-Broadway green stage show realities; members of the aforementioned UNIVERSAL POPULACE™ off-off-Broadway screen stage show presentations; members of the aforementioned UNIVERSAL POPULACE™ off-Broadway pilots; members of the aforementioned UNIVERSAL POPULACE™ off-Broadway productions; members of the aforementioned RSAL POPULACE™ off-Broadway programs; members of the aforementioned UNIVERSAL POPULACE™ off-Broadway performances; members of the aforementioned UNIVERSAL POPULACE™ off-Broadway documentaries; members of the aforementioned UNIVERSAL POPULACE™ off-Broadway acts; members of the aforementioned UNIVERSAL POPULACE™ off-Broadway plays; members of the aforementioned UNIVERSAL POPULACE™ off-Broadway sitcoms; members of the aforementioned UNIVERSAL POPULACE™ off-Broadway shows; members of the aforementioned UNIVERSAL POPULACE™ off-Broadway games; members of the aforementioned UNIVERSAL POPULACE™ off-Broadway realities; members of the aforementioned UNIVERSAL POPULACE™ off-Broadway presentations; members of the aforementioned UNIVERSAL POPULACE™ off-Broadway screen pilots; members of the aforementioned UNIVERSAL POPULACE™ off-Broadway screen productions; members of the aforementioned UNIVERSAL POPULACE™ off-Broadway s creen programs; members of the aforementioned UNIVERSAL POPULACE™ off-Broadway screen performances; members of the aforementioned UNIVERSAL POPULACE™ off-Broadway screen documentaries; members of the aforementioned UNIVERSAL POPULACE™ off-Broadway screen acts; members of the aforementioned UNIVERSAL POPULACE™ off-Broadway screen plays; members of the aforementioned UNIVERSAL POPULACE™ off-Broadway screen sitcoms; members of the aforementioned the aforementioned UNIVERSAL POPULACE™ off-Broadway screen realities; members of the aforementioned UNIVERSAL POPULACE™ off-Broadway screen presentations; members of the aforementioned UNIVERSAL POPULACE™ off-Broadway screen stage pilots; members of the aforementioned UNIVERSAL POPULACE™ off-Broadway screen stage productions; members of the aforementioned UNIVERSAL POPULACE™ off-Broadway screen stage programs; members of the aforementioned UNIVERSAL POPULACE™ off-Broadway screen stage performances; members of the aforementioned UNIVERSAL POPULACE™ off-Broadway screen stage documentaries; members of the aforementioned UNIVERSAL POPULACE™ off-Broadway screen stage acts; members of the aforementioned UNIVERSAL POPULACE™ off-Broadway screen stage plays; members of the aforementioned UNIVERSAL POPULACE™ off-Broadway screen stage sitcoms; members of the aforementioned UNIVERSAL POPULACE™ off-Broadway screen stage shows; members of the aforementioned UNIVERSAL POPULACE™ off-Broadway screen stage games; members of the aforementioned UNIVERSAL POPULACE™ off-Broadway screen stage realities; members of the aforementioned UNIVERSAL POPULACE™ off-Broadway screen stage presentations; members of the aforementioned UNIVERSAL POPULACE™ off-Broadway screen stage show pilots; members of the aforementioned UNIVERSAL POPULACE™ off-Broadway screen stage show productions; members of the aforementioned UNIVERSAL POPULACE™ off-Broadway screen stage show programs; members of the aforementioned UNIVERSAL POPULACE™ off-Broadway screen stage show performances; members of the aforementioned UNIVERSAL POPULACE™ off-Broadway screen stage show documentaries; members of the aforementioned UNIVERSAL POPULACE™ off-Broadway screen stage show acts; members of the aforementioned UNIVERSAL POPULACE™ off-Broadway screen stage show plays; members of the aforementioned UNIVERSAL POPULACE™ off-Broadway screen stage show sitcoms; members of the aforementioned UNIVERSAL POPULACE™ off-Broadway screen stage show shows; members of the aforementioned UNIVERSAL POPULACE™ off-Broadway screen stage show games; members of the aforementioned UNIVERSAL POPULACE™ off-Broadway screen stage show realities; members of the aforementioned UNIVERSAL POPULACE™ UNIVERSAL POPULACE™ radio network productions; members of the aforementioned UNIVERSAL POPULACE™ radio network programs; members of the aforementioned UNIVERSAL POPULACE™ radio network performances; members of the aforementioned UNIVERSAL POPULACE™ radio network documentaries; members of the aforementioned UNIVERSAL POPULACE™ radio network acts; members of the aforementioned UNIVERSAL POPULACE™ radio network plays; members of the aforementioned UNIVERSAL POPULACE™ radio network sitcoms; members of the aforementioned UNIVERSAL POPULACE™ radio network shows; members of the aforementioned UNIVERSAL POPULACE™ radio network games; members of the aforementioned UNIVERSAL POPULACE™ radio network realities; members of the aforementioned UNIVERSAL POPULACE™ radio network presentations; members of the aforementioned UNIVERSAL POPULACE™ radio network screen pilots; members of the aforementioned UNIERSAL POPULACE™ radio network screen productions; members of the aforementioned UNIVERSAL POPULACE™ radio network screen programs; members of the aforementioned UNIVERSAL POPULACE™ radio network screen performances; members of the aforementioned UNIVERSAL POPULACE™ radio network screen documentaries; members of the aforementioned UNIVERSAL POPULACE™ radio network screen acts; members of the aforementioned UNIVERSAL POPULACE™ radio network screen plays; members of the aforementioned UNIVERSAL POPULACE™ radio network screen sitcoms; members of the aforementioned UNIVERSAL POPULACE™ radio network screen shows: members of the aforementioned UNIVERSAL POPULACE™ radio network screen games; members of the aforementioned UNIVERSAL POPULACE™ radio network screen realities; members of the aforementioned UNIVERSAL POPULACE™ radio network screen presentations; members of the aforementioned UNIVERSAL POPULACE™ radio network screen stage pilots; members of the aforementioned UNIVERSAL POPULACE™ radio network screen stage productions; members of the aforementioned UNIVERSAL POPULACE™ radio network screen stage programs; members of the aforementioned UNIVERSAL POPULACE™ radio network screen stage performances; members of the aforementioned UNIVERSAL POPULACE™ radio network screen stage documentaries; members of the members of the aforementioned UNIVERSAL POPULACE™ radio network screen stage sitcoms; members of the aforementioned UNIVERSAL POPULACE™ radio network screen stage shows; members of the aforementioned UNIVERSAL POPULACE™ radio network screen stage games; members of the aforementioned UNIVERSAL POPULACE™ radio network screen stage realities; members of the aforementioned UNIVERSAL POPULACE™ radio network screen stage presentations; members of the aforementioned UNIVERSAL POPULACE™ radio network screen stage show pilots; members of the aforementioned UNIVERSAL POPULACE™ radio network screen stage show productions; members of the aforementioned UNIVERSAL POPULACE™ radio network screen stage show programs; members of the aforementioned UNIVERSAL POPULACE™ radio network screen stage show performances; members o the aforementioned UNIVERSAL POPULACE™ radio network screen stage show documentaries; members of the aforementioned UNIVERSAL POPULACE™ radio network screen stage show acts; members of the aforementioned UNIVERSAL POPULACE™ radio network screen stage show plays; members of the aforementioned UNIVERSAL POPULACE™ radio network screen stage show sitcoms; members of the aforementioned UNIVERSAL POPULACE™ radio network screen stage show shows; members of the aforementioned UNIVERSAL POPULACE™ radio network screen stage show games; members of the aforementioned UNIVERSAL POPULACE™ radio network screen stage show realities; members of the aforementioned UNIVERSAL POPULACE™ radio network screen stage show presentations; members of the aforementioned UNIVERSAL POPULACE™ network television, movie and radio pilots, members of the aforementioned UNIVERSAL POPULACE™ network television, movie and radio productions; members of the aforementioned UNIVERSAL POPULACE™ network television, movie and radio programs; members of the aforementioned UNIVERSAL POPULACE™ network television, movie and radio performances; members of the aforementioned UNIVERSAL POPULACE™ network television, movie and radio documentaries; members of the aforementioned UNIVERSAL POPULACE™ network television, movie and radio acts; members of the aforementioned UNIVERSAL POPULACE™ network television, movie and radio plays; members of the aforementioned shows; members of the aforementioned UNIVERSAL POPULACE™ network television, movie and radio games; members of the aforementioned UNIVERSAL POPULACE™ network television, movie and radio realities; members of the aforementioned UNIVERSAL POPULACE™ network television, movie and radio presentations; members of the aforementioned UNIVERSAL POPULACE™ network television, movie and radio screen pilots; members of the aforementioned UNIVERSAL POPULACE™ network television, movie and radio screen productions; members of the aforementioned UNIVERSAL POPULACE™ network television, movie and radio screen programs; members of the aforementioned UNIVERSAL POPULACE™ network television, movie and radio screen performances; members of the aforementioned UNIVERSAL POPULACE™ network television, movie and radio screen documentaries; members of the aforementioned UNIVERSAL POPULACE™ network television, movie and radio screen acts; members of the aforementioned UNIVERSAL POPULACE™ network television, movie and radio screen plays; members of the aforementioned UNIVERSAL POPULACE™ network television, movie and radio screen sitcoms; members of the aforementioned UNIVERSAL POPULACE™ network television, movie and radio screen shows; members of the aforementioned UNIVERSAL POPULACE™ network television, movie and radio screen games; members of the aforementioned UNIVERSAL POPULACE™ network television, movie and radio screen realities; members of the aforementioned UNIVERSAL POPULACE™ network television, movie and radio screen presentations; members of the aforementioned UNIVERSAL POPULACE™ network television, movie and radio screen stage pilots; members of the aforementioned UNIVERSAL POPULACE™ network television, movie and radio screen stage productions; members of the aforementioned UNIVERSAL POPULACE™ network television, movie and radio screen stage programs; members of the aforementioned UNIVERSAL POPULACE™ network television, movie and radio screen stage performances; members of the aforementioned UNIVERSAL POPULACE™ network television, movie and radio screen stage documentaries; members of the aforementioned UNIVERSAL POPULACE™ network television, movie and radio screen stage acts; members of the aforementioned UNIVERSAL POPULACE™ network television, movie aforementioned UNIVERSAL POPULACE™ network television, movie and radio screen stage shows; members of the aforementioned UNIVERSAL POPULACE™ network television, movie and radio screen stage games; members of the aforementioned UNIVERSAL POPULACE™ network television, movie and radio screen stage realities; members of the aforementioned UNIVERSAL POPULACE™ network television, movie and radio screen stage presentations; members of the aforementioned UNIVERSAL POPULACE™ network television, movie and radio screen stage show pilots; members of the aforementioned UNIVERSAL POPULACE™ network television, movie and radio screen stage show productions; members of the aforementioned UNIVERSAL POPULACE™ network television, movie and radio screen stage show programs; members of the aforementioned UNIVERSAL POPULACE™ network television, movie and radio screen stage show performances; members of the aforementioned UNIVERSAL POPULACE™ network television, movie and radio screen stage show documentaries; members of the aforementioned UNIVERSAL POPULACE™ network television, movie and radio screen stage show acts; members of the aforementioned UNIVERSAL POPULACE™ network television, movie and radio screen stage show plays; members of the aforementioned UNIVERSAL POPULACE™ network television, movie and radio screen stage show sitcoms; members of the aforementioned UNIVERSAL POPULACE™ network television, movie and radio screen stage show shows; members of the aforementioned UNIVERSAL POPULACE™ network television, movie and radio screen stage show games; members of the aforementioned UNIVERSAL POPULACE™ network television, movie and radio screen stage show realities; members of the aforementioned UNIVERSAL POPULACE™ network television, movie and radio screen stage show presentations; members of the aforementioned UNIVERSAL POPULACE™ cinematic artificial satellite, cable, television and movie network pilots; members of the aforementioned UNIVERSAL POPULACE™ cinematic artificial satellite, cable, television and movie network productions; members of the aforementioned UNIVERSAL POPULACE™ cinematic artificial satellite, cable, television and movie network programs; members of the aforementioned UNIVERSAL POPULACE™ cinematic artificial satellite, cable, television and movie network performances; members of the aforementioned cinematic artificial satellite, cable, television and movie network acts; members of the aforementioned UNIVERSAL POPULACE™ cinematic artificial satellite, cable, television and movie network plays; members of the aforementioned UNIVERSAL POPULACE™ cinematic artificial satellite, cable, television and movie network sitcoms; members of the aforementioned UNIVERSAL POPULACE™ cinematic artificial satellite, cable, television and movie network shows; members of the aforementioned UNIVERSAL POPULACE™ cinematic artificial satellite, cable, television and movie network games; members of the aforementioned UNIVERSAL POPULACE™ cinematic artificial satellite, cable, television and movie network realities; members of the aforementioned UNIVERSAL POPULACE™ cinematic artificial satellite, cable, television and movie network presentations; members of the aforementioned UNIVERSAL POPULACE™ cinematic artificial satellite, cable, television and movie network screen pilots; members of the aforementioned UNIVERSAL POPULACE™ cinematic artificial satellite, cable, television and movie network screen productions; members of the aforementioned UNIVERSAL POPULACE™ cinematic artificial satellite, cable, television and movie network screen programs; members of the aforementioned UNIVERSAL POPULACE™ cinematic artificial satellite, cable, television and movie network screen performances; members of the aforementioned UNIVERSAL POPULACE™ cinematic artificial satellite, cable, television and movie network screen documentaries; members of the aforementioned UNIVERSAL POPULACE™ cinematic artificial satellite, cable, television and movie network screen acts; members of the aforementioned UNIVERSAL POPULACE™ cinematic artificial satellite, cable, television and movie network screen plays; members of the aforementioned UNIVERSAL POPULACE™ cinematic artificial satellite, cable, television and movie network screen sitcoms; members of the aforementioned UNIVERSAL POPULACE™ cinematic artificial satellite, cable, television and movie network screen shows; members of the aforementioned UNIVERSAL POPULACE™ cinematic artificial satellite, cable, television and movie network screen games; members of the aforementioned UNIVERSAL POPULACE™ cinematic artificial satellite, cable, television and movie network screen realities; members of the aforementioned UNIVERSAL POPULACE™ cinematic artificial satellite, cable, television and movie stage pilots; members of the aforementioned UNIVERSAL POPULACE™ cinematic artificial satellite, cable, television and movie network screen stage productions; members of the aforementioned UNIVERSAL POPULACE™ cinematic artificial satellite, cable, television and movie network screen stage programs; members of the aforementioned UNIVERSAL POPULACE™ cinematic artificial satellite, cable, television and movie network screen stage performances; members of the aforementioned UNIVERSAL POPULACE™ cinematic artificial satellite, cable, television and movie network screen stage documentaries; members of the aforementioned UNIVERSAL POPULACE™ cinematic artificial satellite, cable, television and movie network screen stage acts; members of the aforementioned UNIVERSAL POPULACE™ cinematic artificial satellite, cable, television and movie network screen stage plays; members of the aforementioned UNIVERSAL POPULACE™ cinematic artificial satellite, cable, television and movie network screen stage sitcoms, members of the aforementioned UNIVERSAL POPULACE™ cinematic artificial satellite, cable, television and movie network screen stage shows; members of the aforementioned UNIVERSAL POPULACE™ cinematic artificial satellite, cable, television and movie network screen stage games; members of the aforementioned UNIVERSAL POPULACE™ cinematic artificial satellite, cable, television and movie network screen stage realities; members of the aforementioned UNIVERSAL POPULACE™ cinematic artificial satellite, cable, television and movie network screen stage presentations; members of the aforementioned UNIVERSAL POPULACE™ cinematic artificial satellite, cable, television and movie network screen stage show pilots; members of the aforementioned UNIVERSAL POPULACE™ cinematic artificial satellite, cable, television and movie network screen stage show productions; members of the aforementioned UNIVERSAL POPULACE™ cinematic artificial satellite, cable, television and movie network screen stage show programs; members of the aforementioned UNIVERSAL POPULACE™ cinematic artificial satellite, cable, television and movie network screen stage show performances; members of the aforementioned UNIVERSAL POPULACE™ cinematic artificial satellite, cable, television and movie network screen stage show documentaries; members of the aforementioned UNIVERSAL POPULACE™ cinematic artificial satellite, cable, television and movie network screen stage show acts; aforementioned UNIVERSAL POPULACE™ cinematic artificial satellite, cable, television and movie network screen stage show sitcoms; members of the aforementioned UNIVERSAL POPULACE™ cinematic artificial satellite, cable, television and movie network screen stage show shows; members of the aforementioned UNIVERSAL POPULACE™ cinematic artificial satellite, cable, television and movie network screen stage show games; members of the aforementioned UNIVERSAL POPULACE™ cinematic artificial satellite, cable, television and movie network screen stage show realities; members of the aforementioned UNIVERSAL POPULACE™ cinematic artificial satellite, cable, television and movie network screen stage show presentations; members of the aforementioned UNIVERSAL POPULACE™ cable, radio, television and movie network pilots; members of the aforementioned UNIVERSAL POPULACE™ cable, radio, television and movie network productions; members of the aforementioned UNIVERSAL POPULACE™ cable, radio, television and movie network programs; members of the aforementioned UNIVERSAL POPULACE™ cable, radio, television and movie network performances; members of the aforementioned UNIVERSAL POPULACE™ cable, radio, television and movie network documentaries; members of the aforementioned UNIVERSAL POPULACE™ cable, radio, television and movie network acts; members of the aforementioned UNIVERSAL POPULACE™ cable, radio, television and movie network plays; members of the aforementioned UNIVERSAL POPULACE™ cable, radio, television and movie network sitcoms; members of the aforementioned UNIVERSAL POPULACE™ cable, radio, television and movie network shows; members of the aforementioned UNIVERSAL POPULACE™ cable, radio, television and movie network games; members of the aforementioned UNIVERSAL POPULACE™ cable, radio, television and movie network realities; members of the aforementioned UNIVERSAL POPULACE™ cable, radio, television and movie network presentations; members of the aforementioned UNIVERSAL POPULACE™ cable, radio, television and movie network screen pilots; members of the aforementioned UNIVERSAL POPULACE™ cable, radio, television and movie network screen productions; members of the aforementioned UNIVERSAL POPULACE™ cable, radio, television and movie network screen programs; members of the aforementioned UNIVERSAL POPULACE™ cable, radio, television and of the aforementioned UNIVERSAL POPULACE™ cable, radio, television and movie network screen acts; members of the aforementioned UNIVERSAL POPULACE™ cable, radio, television and movie network screen plays; members of the aforementioned UNIVERSAL POPULACE™ cable, radio, television and movie network screen sitcoms members of the aforementioned UNIVERSAL POPULACE™ cable, radio, television and movie network screen shows; members of the aforementioned UNIVERSAL POPULACE™ cable, radio, television and movie network screen games; members of the aforementioned UNIVERSAL POPULACE™ cable, radio, television and movie network screen realities; members of the aforementioned UNIVERSAL POPULACE™ cable, radio, television and movie network screen presentations; members of the aforementioned UNIVERSAL POPULACE™ cable, radio, television and movie network screen stage pilots; members of the aforementioned UNIVERSAL POPULACE™ cable, radio, television and movie network screen stage productions; members of the aforementioned UNIVERSAL POPULACE™ cable, radio, television and movie network screen stage programs; members of the aforementioned UNIVERSAL POPULACE™ cable, radio, television and movie network screen stage performances; members of the aforementioned UNIVERSAL POPULACE™ cable, radio, television and movie network screen stage documentaries; members of the aforementioned UNIVERSAL POPULACE™ cable, radio, television and movie network screen stage acts; members of the aforementioned UNIVERSAL POPULACE™ cable, radio, television and movie network screen stage plays; members of the aforementioned UNIVERSAL POPULACE™ cable, radio, television and movie network screen stage sitcoms; members of the aforementioned UNIVERSAL POPULACE™ cable, radio, television and movie network screen stage shows; members of the aforementioned UNIVERSAL POPULACE™ cable, radio, television and movie network screen stage games; members of the aforementioned UNIVERSAL POPULACE™ cable, radio, television and movie network screen stage realities; members of the aforementioned UNIVERSAL POPULACE™ cable, radio, television and movie network screen stage presentations; members of the aforementioned UNIVERSAL POPULACE™ cable, radio, television and movie network screen stage show pilots; members of the aforementioned UNIVERSAL POPULACE™ cable, radio, screen stage show programs; members of the aforementioned UNIVERSAL POPULACE™ cable, radio, television and movie network screen stage show performances; members of the aforementioned UNIVERSAL POPULACE™ cable, radio, television and movie network screen stage show documentaries; members of the aforementioned UNIVERSAL POPULACE™ cable, radio, television and movie network screen stage show acts; members of the aforementioned UNIVERSAL POPULACE™ cable, radio, television and movie network screen stage show plays; members of the aforementioned UNIVERSAL POPULACE™ cable, radio, television and movie network screen stage show sitcoms; members of the aforementioned UNIVERSAL POPULACE™ cable, radio, television and movie network screen stage show shows; members of the aforementioned UNIVERSAL POPULACE™ cable radio television and movie network screen stage show games; members of the aforementioned UNIVERSAL POPULACE™ cable, radio, television and movie network screen stage show realities; members of the aforementioned UNIVERSAL POPULACE™ cable, radio, television and movie network screen stage show presentations; members of the aforementioned UNIVERSAL POPULACE™ artificial satellite radio, television and movie network pilots; members of the aforementioned UNIVERSAL POPULACE™ artificial satellite radio, television and movie network productions; members of the aforementioned UNIVERSAL POPULACE™ artificial satellite radio, television and movie network programs, members of the aforementioned UNIVERSAL POPULACE™ artificial satellite radio, television and movie network performances; members of the aforementioned UNIVERSAL POPULACE™ artificial satellite radio, television and movie network documentaries; members of the aforementioned UNIVERSAL POPULACE™ artificial satellite radio, television and movie network acts; members of the aforementioned UNIVERSAL POPULACE™ artificial satellite radio, television and movie network plays; members of the aforementioned UNIVERSAL POPULACE™ artificial satellite radio, television and movie network sitcoms; members of the aforementioned UNIVERSAL POPULACE™ artificial satellite radio, television and movie network shows; members of the aforementioned UNIVERSAL POPULACE™ artificial satellite radio, television and movie network games; members of the aforementioned UNIVERSAL POPULACE™ artificial presentations; members of the aforementioned UNIVERSAL POPULACE™ artificial satellite radio, television and movie network screen pilots, members of the aforementioned UNIVERSAL POPULACE™ artificial satellite radio, television and movie network screen productions; members of the aforementioned UNIVERSAL POPULACE™ artificial satellite radio, television and movie network screen programs; members of the aforementioned UNIVERSAL POPULACE™ artificial satellite radio, television and movie network screen performances; members of the aforementioned UNIVERSAL POPULACE™ artificial satellite radio, television and movie network screen documentaries; members of the aforementioned UNIVERSAL POPULACE™ artificial satellite radio, television and movie network screen acts; members of the aforementioned UNIVERSAL POPULACE™ artificial satellite radio, television and movie network screen plays; members of the aforementioned UNIVERSAL POPULACE™ artificial satellite radio, television and movie network screen sitcoms, members of the aforementioned UNIVERSAL POPULACE™ artificial satellite radio, television and movie network screen shows; members of the aforementioned UNIVERSAL POPULACE™ artificial satellite radio, television and movie network screen games; members of the aforementioned UNIVERSAL POPULACE™ artificial satellite radio, television and movie network screen realities; members of the aforementioned UNIVERSAL POPULACE™ artificial satellite radio, television and movie network screen presentations; members of the aforementioned UNIVERSAL POPULACE™ artificial satellite radio, television and movie network screen stage pilots; members of the aforementioned UNIVERSAL POPULACE™ artificial satellite radio, television and movie network screen stage productions; members of the aforementioned UNIVERSAL POPULACE™ artificial satellite radio, television and movie network screen stage programs; members of the aforementioned UNIVERSAL POPULACE™ artificial satellite radio, television and movie network screen stage performances; members of the aforementioned UNIVERSAL POPULACE™ artificial satellite radio, television and movie network screen stage documentaries; members of the aforementioned UNIVERSAL POPULACE™ artificial satellite radio, television and movie network screen stage acts; members of the aforementioned UNIVERSAL POPULACE™ artificial satellite radio, television and movie network screen stage plays; members of the POPULACE™ artificial satellite radio, television and movie network screen stage shows; members of the aforementioned UNIVERSAL POPULACE™ artificial satellite radio, television and movie network screen stage games; members of the aforementioned UNIVERSAL POPULACE™ artificial satellite radio, television and movie network screen stage realities; members of the aforementioned UNIVERSAL POPULACE™ artificial satellite radio, television and movie network screen stage presentations; members of the aforementioned UNIVERSAL POPULACE™ artificial satellite radio, television and movie network screen stage show pilots; members of the aforementioned UNIVERSAL POPULACE™ artificial satellite radio, television and movie network screen stage show productions; members of the aforementioned UNIVERSAL POPULACE™ artificial satellite radio, television and movie network screen stage show programs; members of the aforementioned UNIVERSAL POPULACE™ artificial satellite radio, television and movie network screen stage show performances; members of the aforementioned UNIVERSAL POPULACE™ artificial satellite radio, television and movie network screen stage show documentaries; members of the aforementioned UNIVERSAL POPULACE™ artificial satellite radio, television and movie network screen stage show acts; members of the aforementioned UNIVERSAL POPULACE™ artificial satellite radio, television and movie network screen stage show plays; members of the aforementioned UNIVERSAL POPULACE™ artificial satellite radio, television and movie network screen stage show sitcoms; members of the aforementioned UNIVERSAL POPULACE™ artificial satellite radio, television and movie network screen stage show shows; members of the aforementioned UNIVERSAL POPULACE™ artificial satellite radio, television and movie network screen stage show games; members of the aforementioned UNIVERSAL POPULACE™ artificial satellite radio, television and movie network screen stage show realities; members of the aforementioned UNIVERSAL POPULACE™ artificial satellite radio, television and movie network screen stage show presentations; inclusive of, without limitation, every and all musical, opera, play, drama, travesty, horror, tragedy, comedy, animation, action, porn, science-fiction and/or theatrical copious works of literary, theatrical, melodius, artistic, sporting, eductional, pleasure, recreational and entertainment audio, video, voice, visual, graphic and/or image compositions, productions, performances, following media: members of the aforementioned UNIVERSAL POPULACE™ PUBLIC FINANCIALS™ statements, members of the aforementioned UNIVERSAL POPULACE™ PUBLIC FINANCIALS™ instruments; members of the aforementioned UNIVERSAL POPULACE™ PUBLIC FINANCIALS™ instruments; members of the aforementioned UNIVERSAL POPULACE™ aforementioned PUBLIC FINANCIALS™ instruments transactional exchange data, members of the aforementioned UNIVERSAL POPULACE™ aforementioned PUBLIC FINANCIALS™ instruments transactional exchange information; and members of the aforementioned UNIVERSAL POPULACE™ legal, regulatory, economic, currency, fiscal, monetary, public accounting, transport reconciling, independent auditing and financial reporting in a single holistically econometric marketplace environment which heretofore is completely devoid of every and all real-time processing and/or reprocessing of data and/or information receiver, wherefrom hereto collectively innate conception, terminological conveyance, indivisible rubric, syntactic oralformulaic, unique artwork, systematic arrangement, differentiated crafting, artistic construct, melodious lyrics, denominative literateness and thereat proprietary multiport revolving chambered binary hunting metallic track encasing hermetic lock up cast casing constrained unified real-time microprocessor machine language object block keyhole combinational software computer code heretofore and hereafter apprehends ancient history fragmenting market inefficiencies. Whereas, it is an undeniable and evidentiary findings of fact, documented reference, logical deductive reasoning and intuitive analytical reasoning that every and all aforementioned fragmenting capital market inefficiencies heretofore evince complete and utter failure to prudently recognize nor responsibly address to completely resolve the tremendously long-held and enormously heart felt unmet needs in the relevant art with useful innovative utility and design solutions via propagating panacean cutting-edge innovative developments and technological advancements propagating actualization of real-time transmuting conductor heliocentrically oscillating steady state holistic ubiquitous continuous spectrum meta-frequency wave train isogeneous gliding wave front compression rhombus gliding beam modular amplification perpetually unabridged header driven signed, encoded, encrypted, enclosed and sealed data packet transmission and receiver conveyance conduits via transduction transform converter of coal, dam, gasoline, diesel, mixed gasoline and oil, or propagating traverse via every and all traditonal mechanical friction and/or chemical reaction to electrical and/or rocket fuel energy via conduit electrical generation and/or electrical battery, wherefrom hereto via every and all advanced electronic locational systematizing geological and/or seismological processes concretizing innovative wheresoever transcendent EPROM, degauss and/or magnetostriction preemptively constrained ferromagnetic alloy, silicon, germanium, biodynamic and/or geomagnetic resonant soundproof and fireclay wall protective fireball impervious microcircuit epoxy casting insulated permeability of artificial semi-conducting microcircuit devices, articles, apparatuses, refractories and/or megastructures internalizing upright orthorhombic tentacular boundless steady state roving antennule transmuting metric conversional transistor transfusing receiver concretizing high-quality holistically steady state heliocentrically synchronizing ubiquitous hunting continuum parallel redundancy cosmos robotizing digitalized galactic transmitting receiver of spatiotemporal emitted broadcasting of real-time microprocessing traversing a single independent portal refractory evincing minutia partible iota beta particle trace element wave front continuous spectrum pulse signaling transmission conveying efficient energizing and fueling powered catalytic conduits via electrogasdynamics, electrogenesis, electrohydraulic, geomagnetic, gyromagnetic, geokinetic and/or thermodynamic rheostat regulated staple galactic iota minutia fueled and powered apparatus article atmospheric, aboveground, underground, underwater, submersible, astronautical galactic and/or astronautical intergalactic engaging articles, apparatuses and/or megastructures: earth-level orthorhombic rhombus plane passive and/or automatizing lightstable; active automatizing thermostat stabilizing and equilibrating articles, apparatuses, megastructures inclusive of thermotaxis biotelemetry; active automatizing liquid fluid and oxygenstable stabilizing and equilibrating biotelemetry; active automatizing pressure stabilizing and equilibrating articles, apparatuses, megastructures inclusive of thermotaxis biotelemetry; active automatizing depressure stabilizing and equilibrating articles, apparatuses, megastructures inclusive of thermotaxis biotelemetry; active automatizing geodynamic spring axial flexible stabilizing and equilibrating resistant stability; active automatizing gyrostable stabilizing and equilibrating spin axis regulated biospheric conduits; inclusive of, without limitation, articles, apparatuses, megastructures inclusive of thermotaxis biotelemetry; active automatizing liquid fluid and oxygenstable stabilizing and equilibrating biotelemetry; active automatizing pressure stabilizing and equilibrating articles, apparatuses, megastructures inclusive of thermotaxis biotelemetry; active automatizing de-pressure stabilizing and equilibrating articles, apparatuses, megastructures inclusive of thermotaxis biotelemetry; active automatizing geodynamic spring axial flexible stabilizing and equilibrating resistant stability; active automatizing gyrostable stabilizing and equilibrating spin axis regulated tropospheric conduits; inclusive of, without limitation, aboveground low-level orthorhombic rhombus plane passive and/or automatizing lightstable, active automatizing thermostat stabilizing and equilibrating articles, apparatuses, megastructures inclusive of thermotaxis biotelemetry; active automatizing liquid fluid and oxygenstable stabilizing and equilibrating biotelemetry; active automatizing pressure stabilizing and equilibrating articles, apparatuses, megastructures inclusive of thermotaxis biotelemetry; active automatizing de-pressure stabilizing and equilibrating articles, apparatuses, megastructures inclusive of thermotaxis biotelemetry; active automatizing geodynamic spring axial flexible stabilizing and equilibrating resistant stability; active automatizing gyrostable stabilizing and equilibrating spin axis regulated stratospheric conduits; inclusive of, without limitation, aboveground mid-level orthorhombic rhombus plane passive and/or automatizing lightstable; active automatizing thermostat stabilizing and equilibrating articles, apparatuses, megastructures inclusive of thermotaxis biotelemetry; active automatizing liquid fluid and oxygenstable stabilizing and equilibrating biotelemetry; active automatizing pressure stabilizing and equilibrating articles, apparatuses, megastructures inclusive of thermotaxis biotelemetry; active automatizing de-pressure stabilizing and equilibrating articles, apparatuses, megastructures inclusive of thermotaxis biotelemetry; active automatizing geodynamic spring axial flexible stabilizing and equilibrating resistant stability; active automatizing gyrostable stabilizing and equilibrating spin axis regulated mesospheric conduits; inclusive of, without limitation, aboveground high-level orthorhombic rhombus plane passive and/or automatizing lightstable; active automatizing thermostat stabilizing and equilibrating articles, apparatuses, megastructures inclusive of thermotaxis biotelemetry; active automatizing liquid fluid and oxygenstable active automatizing de-pressure stabilizing and equilibrating articles, apparatuses, megastructures inclusive of thermotaxis biotelemetry; active automatizing geodynamic spring axial flexible stabilizing and equilibrating resistant stability; active automatizing gyrostable stabilizing and equilibrating spin axis regulated ionosphere conduits; inclusive of, without limitation, aboveground super-high orthorhombic rhombus plane passive and/or automatizing lightstable; active automatizing thermostat stabilizing and equilibrating articles, apparatuses, megastructures inclusive of thermotaxis biotelemetry; active automatizing liquid fluid and oxygenstable stabilizing and equilibrating biotelemetry; active automatizing pressure stabilizing and equilibrating articles, apparatuses, megastructures inclusive of thermotaxis biotelemetry; active automatizing de-pressure stabilizing and equilibrating articles, apparatuses, megastructures inclusive of thermotaxis biotelemetry; active automatizing geodynamic spring axial flexible stabilizing and equilibrating resistant stability; active automatizing gyrostable stabilizing and equilibrating spin axis regulated thermospheric conduits; inclusive of, without limitation, aboveground astronautical aerospace orbital and/or transcendental translucent exploratory spatiotemporal astronautical outer space galaxy orthorhombic rhombus plane passive and/or automatizing lightstable; active automatizing thermostat stabilizing and equilibrating articles, apparatuses, megastructures inclusive of thermotaxis biotelemetry; active automatizing liquid fluid and oxygenstable stabilizing and equilibrating biotelemetry; active automatizing pressure stabilizing and equilibrating articles, apparatuses, megastructures inclusive of thermotaxis biotelemetry; active automatizing de-pressure stabilizing and equilibrating articles, apparatuses, megastructures inclusive of thermotaxis biotelemetry; active automatizing geodynamic spring axial flexible stabilizing and equilibrating resistant stability; active automatizing gyrostable stabilizing and equilibrating spin axis regulated artificial satellite conduits; wherefrom concretizing, ascertaining, accomplishing, achieving and/or actualizing via propagating real-time transmuting conductor heliocentrically oscillating steady state holistic ubiquitous continuous spectrum meta-frequency wave train isogeneous gliding wave front compression rhombus gliding beam modular amplification perpetually unabridged header driven signed, encoded, encrypted, enclosed and sealed data packet transmission and receiver conveyance conduits via elements, components, constituents, ingredients, processes, methods and combinations which generally and broadly entail, encompass, comprise, involve, impact and/or effect ancient history analogue and present panacean cutting-edge digitalized sound audio, graphic video, visual imaging and/or voice, texture and numerical message signaling traversed via propagating real-time transmuting conductor heliocentrically oscillating steady state holistic ubiquitous continuous spectrum meta-frequency wave train isogeneous gliding wave front compression rhombus gliding beam modular amplification transmission and receiver conveyance conduits via transduction transform converter, wherefrom further are comprehensively suitable, generally pertinent and broadly useful entailing, encompassing, comprising, involving, impacting and/or effecting every and all electrograph, electrostatic, electrothermal, photographic, xerographic, thermographic, thermostatic, thermoelectric, telecast, teletext, teletype, televise, telefacsimile, telegraphy, telemetry, telephony, wire, cable, fiber, film, optic, glass, infrared, radio, television, cinema, radar and/or artificial satellite streamlined processes, methods and combinations of automatizing real-time transmission propagating transporting transmuting partible beta particle beam gliding transponder converting receiver conduit aforementioned UCMOST™ real-time processing and/or reprocessing, wherefrom hereto collectively innate conception, terminological conveyance, indivisible rubric, syntactic oralformulaic, unique artwork, systematic arrangement, differentiated crafting, artistic construct, melodious lyrics, denominative literateness and thereat proprietary multiport revolving chambered binary hunting metallic track encasing hermetic lock up cast casing constrained unified real-time microprocessor machine language object block keyhole combinational software computer code heretofore and hereafter apprehends UNIVERSAL CAPITAL MARKET™ communications, proprietary trademark and service mark is exclusive proprietary intellectual property belonging exclusively and unequivocally to Juan Carlos Castro. Wherefrom every and all communications inclusive of every and all aforementiond UNIVERSAL CAPITAL MARKET™ conceptual aids heretofore and hereafter propagating every and all aforementioned fragmenting capital market inefficiencies are herewith undeniably, logically, scientifically and intuitively evinced as comprehensively imprudent, generally insolent and broadly unacceptable traversing every and all heliocentrically oscillating steady state holistic ubiquitous continuous spectrum meta-frequency wave train isogeneous gliding wave front compression rhombus gliding beam modular amplification perpetually unabridged header driven signed, encoded, encrypted, enclosed and sealed data packet transmission and receiver conveyance conduits via transduction transform converter, wherefrom furthermore supplanting every and all heretofore ancient history fragmenting market inefficiencies which are propagating via every and all, without limitation antiquated, archaic, ancient history and superannuated analogue and/or digitalized sound audio, graphic video, visual imaging and/or voice, texture, character and/or numerical message signaling via negative conduit promulgations traversing via so-called header driven data packet wire jaack and/or wireless transmission and/or receiver to/from every and all heretofore conduits evincing inefficient, portentous and fruitless proliferation of the so-called Internet in connection with the so-called World Wide Web; whereas, the present invention supplants these forms of communicating, broadcasting, transporting and/or combinations inclusive of, without limitation, every and all antiquated, archaic, ancient history and superannuated so-called server techniques, designs, systems, routines, devices, manners, modes, fashions, forms, formats, factors, objects, parts, segments, elements, components, constituents, ingredients, processes, methods and combinations. Whereas, the so-called Internet inclusive of the so-called World Wide Web inevitably induces and/or evinces actualization of large-scale and widespread holistic confusion and tempestuous diminishing returns on transactional exchanges and tempestuous diminishing returns on residual equities attributable explictly to every and all aforementioned fragmenting capital market inefficiencies; wherefrom heretofore inevitably induces tempestuous exponentially detrimental exponential increases in systematic volatility and tempestuous exponentially debilitating exponential increases in the cost of capital within a capital market wherefrom also undeniably, are legally, undeniably, logically, scientifically and intuitively further induces large-scale and widespread holistically tempestuous devaluation aforementioned PUBLIC FINANCIALS™ instruments inclusive of tempestuous diminished trust and confidence members of the aforementioned UNIVERSAL POPULACE™ within the aforementioned PUBLIC FINANCIALS™ statements from members of the aforementioned UNIVERSAL superannuated legal, regulatory, economic, currency, fiscal, monetary, accounting, auditing and reporting in a single holistically econometric marketplace environment which heretofore is completely devoid of every and all real-time processing and/or reprocessing of data and/or information which is necessary to recognize and address to offer absolute resolution to the tremendously long-held and enormously heart-felt needs in the relevant art. Whereas, it is deemed necessary to offer members the hundreds of millions of members of the aforementioned UNIVERSAL POPULACE™ a novel and unobvious innovative cutting-edge, breakthrough and groundbreaking technological development and advancement to offer the highlest levels of assurance within a capital market which is comprehensively suitable, generally pertinent and broadly useful to the sustenance, stability, productivity, growth and expansion entailing, encompassing, comprising, involving, impacting and/or effecting every and all holistically transactional exchange initiatives, schemes, ocurrences, happenings, interactions, processes, methods, practices, movements, proceedings, messaging, presentations, notifications, filings, submissions, records, activities, actions, events, endeavors, tasks and affairs inclusive of the employment status of the universal labor force comprising every and all national sovereign borders of every and all industrialized, developed and developing free-market commerce and trade bloc economies concretizing aforementiond UCMOST real-time processing and/or reprocessing anywhere, anytime and anyplace within a holistically universal marketplace environment. Whereas, furthermore hereto it is also undeniably, respectively, independently, autonomously, evidently, undeniably, logically, scientifically, intuitively and unequivocally necessary to mitigate every and all of the tremendously overburdening and enormously overwhelming unacceptable, undeniable, unnecessary, unwarranted, illogical, unjustifiable, unreasoned and unmitigated, unsubstantiated and unjustified large-scale and wide-spread holistically contagion throughout involving the antiquated, archaic, ancient history and superannuated inefficient, ineffective, dysfunctional and disintegrated so-called U.S. capital market inclusive of, without limitation, the antiquated, archaic, ancient history and superannuated inefficient, ineffective, dysfunctional and disintegrated W.W. capital markets, collectively. It is further an undeniable and evidentiary findings of fact, documented reference, logical scientific deduction and intuitive analytical reasoning herewith readily identified as prior-art references never anticipated, neever recognized and never addressed the multifacted and multidimensional layers of aforementioned fragmenting capital market inefficiencies to strive toward propagating, promulgating and proclaiming immediate and unequivocal consummate absolute resolution via necessary research developments and technological advancements evincing constructive reduction to practice an innovation concretizing natural and streamlined techniques, designs, systems, routines, devices, manners, modes, fashions, forms, formats, factors, objects, parts, segments, elements, components, constituents, ingredients, processes, methods and combinations to offer an unappealable and unexceptionable absolute resolution to all of the tremendously long-held and enormously heart-felt umnet needs in the relevant art, which are herewith conceived, engineered, designed and developed and traversed via consummate and constructive reduction to practice evincing a comprehensively suitable, generally pertinent and broadly useful resolution via invoking aforementioned UCMOST™ information technology; whereas, serving all members of the aforementioned UNIVERSAL POPULACE™ via all basic functional elements, necessary interactions and integral transactional exchange initiatives, schemes, ocurrences, happenings, interactions, processes, methods, practices, movements, proceedings, messaging, presentations, notifications, filings, submissions, records, activities, actions, events, endeavors, tasks and affairs found to be prevalent and actualizable within an aforementioned efficient UNIVERSAL CAPITAL MARKET™. The fact that various prior-art references never anticipated, never recognized and never addressed the tremendously long-held and heartfelt unmet needs in the relevant art is likely explainable via comprehensive arrogance combined with unlettered, ignorant, untaught and unpolished qualities, talents and skills of comprehending and apprehending utility and design art formulation; wherefrom thereby evincing globally predisposed servile adherence and unreasoned utopian acceptance of an extremely limited abstract conceptual understanding of the basic functional elements, necessary interactions and integral transactional exchange initiatives, schemes, ocurrences, happenings, interactions, processes, methods, practices, movements, proceedings, messaging, presentations, notifications, filings, submissions, records, activities, actions, events, endeavors, tasks and affairs which occur, happen and/or transpire within an logically, reference, scientificaly and intuitively notwithstanding, thus predisposing the prior-art skilled practitioners into unwarranted belief of difficulty in entirely conceptualizing the innate and intrinsic premise of the aforementioned efficient UNIVERSAL CAPITAL MARKET™ within a single holistically econometric marketplace environment for a necessarily integrated, critically important and increasing integral aforementioned efficient UNIVERSAL ECONOMY™. Thus, heretofore every and all aforementioned fragmenting capital market inefficiencies evince an extremely large number of predatory and entrenched major, top-tier, prominent, well-established, well-capitalized and powerful competitive forces found prevalent heretofore in the varying multifaceted industries and multidimensional sectors generally and broadly preying on members of the aforementioned UNIVERSAL POPULACE™. Whereas, every and all fraudulent activities and predatory market behavior propagated, proclaimed and promulgated via the vast network of inefficient intermediary network of members of the aforementioned UNIVERSAL POPULACE™, which heretofore are operational throughout the world in the distinctively separate and traditionally exclusive speciality areas of public accounting, transport reconciling, independent auditing and financial reporting and the distinctively separate and traditionally exclusive speciality areas of order-entry quotation, matching, clearance, execution, settlement and exchange of insurance, risk financing, credit, cash management, investment banking and aforementioned PUBLIC FINANCIALS™ instruments. Whereas, heretofore continuously prevailing in circumventing every and all propagation and promulgation of necessary innovative developments and technological advancements in natural and streamlined techniques, designs, systems, routines, devices, manners, modes, fashions, forms, formats, factors, objects, parts, segments, elements, components, constituents, ingredients, processes, methods and combinations to innately and inherently concretize full disclosure, best practices, best executions, enhanced fairness, simulteanoues equality, full transparency, consolidated access and perpetual integration within an aforementioned efficient UNIVERSAL CAPITAL MARKET™ wherefrom hereto actualizing optimized and efficient transport flow of holistically steady state indistinguishably synchronized real-time processing of data and/or information receiver traversed via streamlined, alternating scale, streamlined, inseparable, seamless and naturally wrapped, twisted, mixed, intertwined, convoluted, coupled and combined aforementioned PUBLIC FINANCIALS™ instruments to concretize optimized and efficient transport flow of holistically steady state indistinguishably synchronized real-time processing of data and/or information receiver content management, financial services and aforementioned PUBLIC FINANCIALS™ instruments transactions. Wherefrom ensuring the highest levels of assurance are offered to members of the aforementioned UNIVERSAL POPULACE™ in combination with the novel, unobvious, unknown, unforeseen, unprecedented, epoch, paper-less, ease of use, fruitful, opportune, never faltering and never failing panacean cutting-edge utility technological engineering and architectural design provisions of software products and professional sevices invoked via aforementioned UCMOST™ information technology concretizes a novel utility and design to effectuate efficient, effective, objective, well-informed, risk-managed and self-assured aforementioned PUBLIC FINANCIALS™ instruments transactional exchange decision initiatives, schemes, ocurrences, happenings, interactions, processes, methods, practices, movements, proceedings, messaging, presentations, notifications, filings, submissions, records, activities, actions, events, endeavors, tasks and affairs to protect, sustain and expand their treasure accounting, financial fueling and econometric energizing in a highy dynamic and inherently volatile, fragile, frigid and ruthless global econometric marketplace environment. Therefrom, it is clearly an undeniable and evidentiary findings of fact, documented reference, logical scientific deduction and intuitive analytical reasoning that individual members of the aforementioned UNIVERSAL POPULACE™ and individual inventors which heretofore participated in innovative developments and technological advancement hereby readily identified in relevant prior-art references never clearly defined the comprehensive capabilities of an efficient flow and data processing and informaiton origination within, throughout and transcending a capital market of a single holistically econometric marketplace environment to thereby strive purposefully and endeavor melioristic logical positivismally to apprehend and streamline every and all basic elements, components, functions, processes, procedures and technological parameters necessarily herewith anticipated, recognized and addressed to properly and promptly resolve the tremendously unprecedented, epoch, paper-less, ease of use, fruitful, opportune, never faltering and never failing panacean cutting-edge utility technological engineering and architectural design innovation which is comprehensively suitable, generally pertinent and broadly useful in streamlining, wrapping, twisting, mixing, intertwining, convoluting, coupling and combining every and all of the distinctively separate and traditionally exclusive specialty areas of public accounting, transport reconciling, independent auditing and financial reporting inclusive of streamlining, wrapping, twisting, mixing, intertwining, convoluting, coupling and combining every and all of the distinctively separate and traditionally exclusive specialty areas order-entry quotation, matching, clearance, execution, settlement and exchange of insurance, alternative risk management, credit, cash management, investment banking, and PUBLIC FINANCIALS™ instruments transactional activities., wherefrom further hereto entailing, encompassing, comprising, involving, impacting and/or effecting every and all present innovative developments and technological advancements in novel techniques, designs, systems, routines, devices, manners, modes, fashions, forms, formats, factors, objects, parts, segments, elements, components, constituents, ingredients, processes, methods and combinations evinced within aforementioned UCMOST™ information technology which are comprehensively suitable, generally pertinent and broadly useful to holistically steady state continuous spectrum ubiquitous indistinguishably synchronous needs involving aforementioned UCMOST™ real-time processing and/or reprocessing of data and/or information content management, financial services and aforementioned PUBLIC FINANCIALS™ instruments transactional exchange initiatives, schemes, ocurrences, happenings, interactions, processes, methods, practices, movements, proceedings, messaging, presentations, notifications, filings, submissions, records, activities, actions, events, endeavors, tasks and affairs. Wherefrom aforementioned UCMOST™ information technology concretizes efficient, effective, functional and integrated streamlining unequivocal absolute resolution of every and all of the tremendously long-held and enormously heart-felt unmet needs in the relevant art which requisite, yearn and plead for all innovative solution hereto comprehensively suitable, generally pertinent and broadly useful panacean cutting-edge technologies entailing, encompassing, comprising, involving, impacting and/or effecting every and all holistically information content management, financial services and aforementioned PUBLIC FINANCIALS™ instruments transactional exchange initiatives, schemes, ocurrences, happenings, interactions, processes, methods, practices, movements, proceedings, messaging, presentations, notifications, filings, submissions, records, activities, actions, events, endeavors, tasks and affairs of every and all whichever within the members of the aforementioned UNIVERSAL POPULACE™ from around the world as naturally logical and entirely propagating by law, but wherefrom perpetual illogical failure to strive to mitigate every and all large-scale and wide-spread holistically confusion which heretofore concretizes tempestuous diminishing returns on transactional exchanges inclusive of tempestuous diminishing returns on residual equities along with tempestuous exponentially detrimental exponential increases in systematic volatility and tempestuous exponentially debilitating exponential increases in the cost of capital which prevent and pleclude formation of a new theater of operations and establishment of higher standards of full disclosure, best practices, best executions, simultaneous equality, full transparency and consolidated access with an aforementioned efficient UNIVERSAL CAPITAL MARKET™ whence therefore it is undeniably, are legally, undeniably, logically, scientifically and intuitively further induced that every and all large-scale and wide-spread holistically tempestuous devaluation aforementioned PUBLIC FINANCIALS™ instruments inclusive of tempestuous diminished trust and confidence members of the aforementioned UNIVERSAL POPULACE™ in senior executives members of the aforementioned UNIVERSAL POPULACE™ inclusive of the overall economic sustenance, stability, productivity, growth and expansion of every and all holistically transactional exchange initiatives, schemes, ocurrences, happenings, interactions, processes, methods, practices, movements, proceedings, messaging, presentations, notifications, filings, submissions, records, activities, actions, events, endeavors, tasks and affairs and the employment status of the global labor force in every and all national sovereign borders of every and all of the industrialized, developed and developing free-market commerce and trade bloc economies shall as heretofore evidently evinced continue harming, damaging, inuring, insistent, insinuating, imposing, pestilent, impetuous, importune, pestiferous, condescending and insolent enthrallment, pretend, harass, engulf, fragmenting capital market inefficiencies which are undeniably, respectively, independently, autonomously, evidently, undeniably, logically, scientifically and intuitively a quintessential prime example of irresponsible and predatory competitive market behavior. Whereas, it is an undeniable and evidentiary findings of fact, documented reference, logical scientific deduction and intuitive analytical reasoning that the aforementioned fragmenting capital market inefficiencies is heretofore in a steady state of derogatory delinquency, denominative delirium and desolate despondency which wherefrom hereby desperately pleads for actualization of full capacity globally integrated utilization of full disclosure, best practices, best executions, enhanced fairness, simultaneous equality, full transparency, consolidated acces and perpetual integration in every and all basic functional elements, necessary interactions and integral transactional exchange initiatives, schemes, ocurrences, happenings, interactions, processes, methods, practices, movements, proceedings, messaging, presentations, notifications, filings, submissions, records, activities, actions, events, endeavors, tasks and affairs which are hereto discovered prevelant within an aforementioned efficient UNIVERSAL CAPITAL MARKET™ to emancipate and enfranchise the members of the aforementioned UNIVERSAL POPULACE™ from every and all fragmented UNIVERSAL CAPITAL MARKET™ inefficiencies wherefrom propagating, promulgating and proclaiming an hereafter imminent and emergent commercialized formation, capitalization, manufacture, testing, development, deployment and implmentation of the novel, unobvious, unknown, unforeseen, unprecedented, epoch, paper-less, ease of use, fruitful, opportune, never faltering and never failing panacean cutting-edge utility technological engineering and architectural design innovations premised on formation of a new theater of operations and establishment of higher standards of full disclosure, best practices, best executions, enhanced fairness, simultaneous equality, full transparency, consolidated acces to concretize an aforementioned efficient UNIVERSAL CAPITAL MARKET™ for a necessarily integrated, critically important and increasingly integral aforementioned efficient UNIVERSAL ECONOMY™, wherefrom hereto collectively innate conception, terminological conveyance, indivisible rubric, syntactic oralformulaic, unique artwork, systematic arrangement, differentiated crafting, artistic construct, melodious lyrics, denominative literateness and thereat proprietary keyhole combinational software computer code heretofore and hereafter apprehends heretofore formally utilized proprietary trademark and/or service mark exclusively owned intellectual property of Juan Carlos Castro, actualizable to perpetually and ubiquitously offer members of the aforementioned UNIVERSAL POPULACE™ via the utility engineering and architectural design of novel product and service provisions derived via aforementioned UCMOST™ information technology to effectuate efficient, effective, objective, well-informed, risk-managed and self-assured aforementioned PUBLIC FINANCIALS™ instruments transactional exchange decision initiatives, schemes, ocurrences, happenings, interactions, processes, methods, practices, movements, proceedings, messaging, presentations, notifications, filings, submissions, records, activities, actions, events, endeavors, tasks and affairs to protect, sustain and expand their treasure accounting, financial fueling and econometric energizing in a highy dynamic and inherently volatile, fragile, frigid and ruthless global marketplace. It is is an undeniable and evidentiary findings of fact, documented reference, logical scientific deduction and logical analytical reasoning that aforementioned UCMOST™ information technology is authentically unique and genuinely original to its broad aim, letter, nature, spirit, depth, breadth and scope of comprehensive arrayed fields of across-the-board specializations wherefrom hereto it is further emphasized that evidently there is no genuine applicable and/or pertient prior-art reference which is directly germane hereto as hereof evinced no public organization nor individual inventor herein readily identified heretofore recognized nor addressed to completely resolve the tremendously long-held and enormously heart-felt unmet needs in the relevant art pleading for immediate propagation and promulgated establishment of optimized and efficient transport flow of holistically steady state indistinguishably synchronized real-time processing of data and/or information receiver comprehensively suitable, generally pertinent and broadly useful to every and all aforementioned PUBLIC FINANCIALS™ statements streamlined, alternating scale, inseparable, seamless and natural wrapping, interlacing, coiling, coupling, combining and interlocking PUBLIC FINANCIALS™ instruments inclusive of streamlined, alternating scale, inseparable, seamless and natural wrapping, interlacing, coiling, coupling, combining and interlocking every and all aforementioned PUBLIC FINANCIALS™ instruments aforementioned PUBLIC FINANCIALS™ instruments transactional exchange information to concretize aforementioned efficient UNIVERSAL CAPITAL MARKET™ via innovating panacean cutting-edge innovative developments and technological advancements wherefrom hereto concretize groundbreaking and breakthrough utility engineering and architectural design propagations traversed in aforementioned UCMOST™ information technology to concretize full capacity holistically integrated utilization of full disclosure, best practices, best executions, enhanced fairness, simultaneous equality, full transparency, consolidated acces and perpetual integration in every and all basic functional elements, necessary interactions and integral transactional exchange initiatives, schemes, ocurrences, happenings, interactions, processes, methods, practices, movements, proceedings, messaging, presentations, notifications, filings, submissions, records, activities, actions, events, endeavors, tasks and affairs which are hereto discovered prevelant within an aforementioned efficient UNIVERSAL CAPITAL MARKET™ premised generally and broadly on the distinctively seperate and traditionally exclusive speciality areas of public accounting, transport reconciling, independent auditing and financial reporting inclusive of order-entry quotation, matching, clearance, execution, settlement and exchange of insurance, alternative risk management, credit, cash management, investment banking, and PUBLIC FINANCIALS™ instruments transactional activities., and which transcends the multifaceted and multidimensional industries and sectors of every and all national sovereign borders of every and all of the industrialized, developed and developing free-market commerce and trade bloc economies throughout a single holistically econometric marketplace environment. Moreover, aforementioned UCMOST™ information technology is further are comprehensively suitable, generally pertinent and broadly useful to every and all economic sustenance, stability, productivity, growth and expansion of every and all holistically transactional exchange initiatives, schemes, ocurrences, happenings, interactions, processes, methods, practices, movements, proceedings, messaging, presentations, notifications, filings, submissions, records, activities, actions, events, endeavors, tasks and affairs inclusive of the employment status of the global labor force which occur, happen and/or transpire anywhere, anytime and anyplace throughout the holistically marketplace environment and thereof requires the degree of assurance offered to members of the aforementioned UNIVERSAL POPULACE™ are comprehensively suitable, generally pertinent and broadly useful to the accuracy, quality, integrity, honor, timeliness, relevance, transparency, reliabilty, verifiability, comprehensiveness, understandability and assurance aforementioned PUBLIC FINANCIALS™ statements inclusive of seamlessly and naturally wrapped, twisted, mixed, convoluted, embroidered and combined in connection with aforementioned PUBLIC FINANCIALS™ instruments reported by members of the aforementioned UNIVERSAL POPULACE™ inclusive of, without limitation, every and all aforementioned PUBLIC FINANCIALS™ instruments transactional exchange data with aforementioned PUBLIC FINANCIALS™ instruments transactional exchange information which occurs and transpires within an aforementioned efficient UNIVERSAL CAPITAL MARKET™. Thus, it is clearly an undeniable and evidentiary findings of fact, documented reference, logical scientific deduction and logical analytical reasoning that no public organization nor individual inventor herein readily identified within the aforementioned prior-art references heretofore recognized nor addressed to completely resolve the unmet need in the relevant art to invoke every and all are comprehensively suitable, generally pertinent and broadly useful knowledge and documentation to formulate a suitable art solution to completely resolve every and all of the tremendously long-held and enormously heart-felt unmet needs in the relevant art which plead for propagating aforementioned UCMOST™ information technology, and which further is are comprehensively suitable, generally pertinent and broadly useful to every and all facets and dimensions which entail, encompass, comprise, involve, impact and/or effect actualizing optimized and efficient transport flow of holistically steady state indistinguishably synchronized real-time processing of data and/or information receiver traversed via streamlined, alternating scale, inseparable, seamless and natural wrapping, interlacing, coiling, coupling, combining and interlocking holistically steady state continuous spectrum ubiquitous indistinguishably synchronous needs involving aforementioned UCMOST™ real-time processing and/or reprocessing of data and/or information content management, financial services and aforementioned PUBLIC FINANCIALS™ instruments transactional exchange initiatives, schemes, ocurrences, happenings, interactions, processes, methods, practices, movements, proceedings, UNIVERSAL POPULACE™ from around the world, which are naturally transacted and necessarily occur, happen and/or transpire anytime, anyplace and anywhere in a single holistically econometric marketplace environment traversed via emergent commercialization of every and all novel utility engineering and architectural design of products and services and prospective innovative developments and technological advancements generally and broadly derived herefrom inherently offer every and all members of the aforementioned UNIVERSAL POPULACE™ full disclosure, best practices, best executions, enhanced fairness, simulteanoues equality, fill transparency, consolidated access and perpetual integration to the novelty utility engineering and architectural design which herewith concretizes a unknown, unforeseen and unprecedented groundbreaking and breakthrough aforementioned efficient UNIERSAL CAPITAL MARKET™ for a necessarily integrated, critically important and increasing integral aforementioned efficient UNIVERSAL ECONOMY™ traversed via multifaceted and multidimensional traversed single independent portal access to integrated closed circuitry automatizing real-time holistically steady state synchronized ubiquitous continuum real-time rhombus microprocessing instantaneous transmission and receiver transforming traverse conduit aforementioned UCMOST™ real-time processing and/or reprocessing of every and all streamlined, alternating scale, inseparable, seamless and natural wrapping, interlacing, coiling, coupling, combining and interlocking aforementioned PUBLIC FINANCIALS™ statements seamlessly and naturally wrapped, twisted, mixed, convoluted, embroidered and combined in connection with aforementioned PUBLIC FINANCIALS™ instruments from members of the aforementioned UNIVERSAL POPULACE™ are comprehensively suitable, generally pertinent and broadly useful to the distincitively separate and traditionally exclusive specialty areas of public accounting, transport reconciling, independent auditing and financial reporting in combination with multifaceted and multidimensional traversed single independent portal access to integrated closed circuitry automatizing real-time holistically steady state synchronized ubiquitous continuum real-time rhombus microprocessing instantaneous transmission and receiver transforming traverse conduit aforementioned UCMOST™ real-time processing and/or reprocessing of every and all streamlined, alternating scale, inseparable, seamless and aforementioned PUBLIC FINANCIALS™ instruments transactional exchange information entailing, encompassing, comprising, involving, impacting and/or effecting every and all order-entry quotation, matching, clearance, execution, settlement and exchange of insurance, risk financing, credit, cash management, investment banking and aforementioned PUBLIC FINANCIALS™ instruments to pursue adamant and rigorous emancipation of every and all heretofore harming, damaging, inuring, insistent, insinuating, imposing, pestilent, impetuous, importune, pestiferous, condescending and insolent enthrallment, pretend, harass, engulf, press, presume, imprint, pester and oppress from the members of the aforementioned UNIVERSAL POPULACE™ from the ancient history vast network of intermediary carrier and/or broker aforementioned PUBLIC FINANCIALS™ organizations heretofore evidently preventing and precluding consolidation among every and all of the distinctively separate and traditionally exclusive speciality areas entailing, encompassing, comprising, involving, impacting and/or effecting every and all real-time processing and/or reprocessing of data and/or information receiver content management, financial services and aforementioned PUBLIC FINANCIALS™ instruments transactional exchange initiatives, schemes, ocurrences, happenings, interactions, processes, methods, practices, movements, proceedings, messaging, presentations, notifications, filings, submissions, records, activities, actions, events, endeavors, tasks and affairs thus precluding and preventing formation of a new theater of operations and establishment of higher standards to concretize an aforementioned efficient UNIVERSAL CAPITAL MARKET™, wherefrom immediate concretizing propagation and promulgation of invoked within aforementioned UCMOST™ information technology in melioristic logical positivism strive and pursuit of emergent commercialized formation and establishment of a novel, unobvious, unknown, unforeseen, unprecedented, epoch, paper-less, ease of use, fruitful, opportune, never faltering and never failing panacean cutting-edge aforemenentioned efficient UNIVERSAL CAPITAL MARKET™ for a necessarily integrated, critically important and increasing integral aforementioned efficient UNIVERSAL ECONOMY™ which herewith evinced is logically feasible, technologically realizable, commercially viable and authentically and originally conceived, engineered, designed and developed via consummate and constructive reduction to practice hereto scientific reasoning and intuitive analytical reasoning that no public organization nor individual inventor herein readily identified within the aforementioned prior-art references recognized nor addressed to completely resolve the manufacturing viability, commercial salability and mass appeal beneficial utility engineering and architectural design of products ad semiceg ate comprehengively suitable, generally pertinent and broadly ugefflI art solution of utility engineering and architectural design provisions of propagating aforementioned UCMOST™ information technology to completely resolve the tremendously long-held and enormously heart-felt unmet needs in the relevant art which heretofore entail, encompass, comprise, involve, impact and/or effect every and all untimely, veiled, holding, hesitant and delayed automatizing real-time transmission propagating transporting transmuting partible beta particle beam gliding transponder converting receiver conduit aforementioned UCMOST™ real-time processing and/or reprocessing of every and all aforementioned PUBLIC FINANCIALS™ statements seamlessly and naturally wrapped, twisted, mixed, convoluted, embroidered and combined in connection with aforementioned PUBLIC FINANCIALS™ instruments from members of the aforementioned UNIVERSAL POPULACE™ are comprehensively suitable, generally pertinent and broadly useful to every and all of the distinctively separate and traditionally exclusive specialty areas entailing, encompassing, comprising, involving, impacting and/or effecting public accounting, transport reconciling, independent auditing and financial reporting, and further no public organization nor individual inventor herein readily identified within the aforementioned prior-art references recognized nor addressed to completely resolve the manufacturing viability, commercial salability and mass appeal beneficial utility engineering and architectural design of products and services are comprehensively suitable, generally pertinent and broadly useful art solution of utility engineering and architectural design provisions within aforementioned UCMOST™ information technology to completely resolve the tremendously long-held and enormously heart-felt unmet needs in the relevant art which heretofore entail, encompass, comprise, involve, impact and/or effect every and all untimely, veiled, holding, hesitant and delayed techniques, methods and processing which are subservient in any and all respects to the novel and unobvious aforementioned UCMOST™ real-time processing and/or reprocessing comprehensively suitable, generally pertinent and broadly useful to the distinctivley separate and traditionally exclusive specialty areas of order-entry quotation, matching, clearance, execution, settlement and exchange entailing, encompassing, comprising, involving, impacting and/or effecting insurance, risk financing, credit, cash management, investment banking and aforementioned PUBLIC FINANCIALS™ instruments. Moreover, it is clearly an undeniable and evidentiary findings of fact, documented reference, logical scientific reasoning and intuitive analytical reasoning that no public organization nor individual inventor herein readily identified within the aforementioned prior-art references recognized nor addressed to completely resolve the manufacturing viability, commercial salability and mass appeal beneficial utility engineering and architectural design of products and services are comprehensively suitable, generally pertinent and broadly useful art solution of utility engineering and architectural design provisions aforementioned UCMOST™ information technology to completely resolve the tremendously long-held and enormously heart-felt unmet needs in the relevant art which heretofore entail, encompass, comprise, involve, impact and/or effect every and all of the evidentiary lack of efficiency, effectiveness, consolidation and integration among every and all of the basic functional elements, necessary interactions and integral transactional exchange initiatives, schemes, ocurrences, happenings, interactions, processes, methods, practices, movements, proceedings, messaging, presentations, notifications, filings, submissions, records, activities, actions, events, endeavors, tasks and affairs which occur, happen and/or transpire within an aforementioned efficient UNIVERSAL CAPITAL MARKET™ which thereof and hreby is inclusive of, without limitation, every and all techniques, designs, systems, routines, devices, manners, modes, fashions, forms, formats, factors, objects, parts, segments, elements, components, constituents, ingredients, processes, methods and combinations necessary to concretize full capacity holistically integrated utilization of full disclosure, best practices, best executions, enhanced fairness, simultaneous equality, full transparency and perpetual integration of every and all of the basic functional elements, necessary interactions and integral transactional exchange initiatives, schemes, ocurrences, happenings, interactions, processes, methods, practices, movements, proceedings, messaging, presentations, notifications, filings, submissions, the millions people and organizations within the members of the aforementioned UNIVERSAL POPULACE™ the highest levels of accuracy, quality, integrity, honor, timeliness, relevance, transparency, reliabilty, verifiability, comprehensiveness, understandability and assurance and utmost degree of assurances which are comprehensively suitable, generally pertinent and broadly useful to improving the accuracy, quality, integrity, honor, timeliness, relevance, transparency, reliabilty, verifiability, comprehensiveness, understandability and assurance of every and all aforementioned PUBLIC FINANCIALS™ statements inclusive of seamlessly and naturally wrapped, twisted, mixed, convoluted, embroidered and combined in connection with aforementioned PUBLIC FINANCIALS™ instruments reported by members of the aforementioned UNIVERSAL POPULACE™ inclusive of, without limitation, the highest levels of accuracy, quality, integrity, honor, timeliness, relevance, transparency, reliabilty, verifiability, comprehensiveness, understandability and assurance and utmost degree of assurance which are comprehensively suitable, generally pertinent and broadly useful to improving the accuracy, quality, integrity, honor, timeliness, relevance, transparency, reliabilty, verifiability, comprehensiveness, understandability and assurance of every and all aforementioned PUBLIC FINANCIALS™ instruments transactional exchange real-time data retrieval with aforementioned PUBLIC FINANCIALS™ instruments transactional exchange real-time information retrieval within an aforementioned efficient UNIVERSAL CAPITAL MARKET™ which as hereafter described, explained, referenced, specified and evinced is deemed to be undeniably, respectively, independently, autonomously, evidently, undeniably, logically, scientifically and intuitively inherently necessary to preemptively preclude every and all large-scale and wide-spread holistically confusion which heretofore concretizes tempestuous diminishing returns on transactional exchanges inclusive of tempestuous diminishing returns on residual equities along with tempestuous exponentially detrimental exponential increases in systematic volatility and tempestuous exponentially debilitating exponential increases in the cost of capital of an aforementioned efficient UNIVERSAL CAPITAL MARKET™ and therefrom undeniably, are legally, undeniably, logically, scientifically and intuitively induces large-scale and wide-spread global tempestuous devaluation aforementioned PUBLIC FINANCIALS™ instruments inclusive UNIVERSAL POPULACE™ are comprehensively suitable, generally pertinent and broadly useful to the overall economic sustenance, stability, productivity, growth and expansion of every and all holistically transactional exchange initiatives, schemes, ocurrences, happenings, interactions, processes, methods, practices, movements, proceedings, messaging, presentations, notifications, filings, submissions, records, activities, actions, events, endeavors, tasks and affairs inclusive of the employment status of the universal labor force in every and all national sovereign borders of every and all of the industrialized, developed and developing free-market commerce and trade bloc economies concretizing anywhere, anytime and anyplace in the holistically marketplace environment, and wherein thereof further every and all of the aforementioned heretofore as herein emphatically described, explained, referenced, specified and evinced are undeniably, respectively, independently, autonomously, evidently, undeniably, logically, scientifically and intuitively overburdening and overwhelmingly undeniable, unnecessary, unwarranted, illogical, unjustifiable, unreasoned and unmitigated, unsubstantiated, unjustified and therefrom induce exponential large-scale and wide-spread holistically contagion with aforementioned fragmenting capital market inefficiencies which in every and all combinatorial fashion heretofore engulf, enthrall and oppress every and all inherently necessary innovative and panacean cutting-edge innovative developments and technological advancements which offer novel artistic utility and design solutions to completely resolve every and all of the tremendoulsy long-held and enormously heart-felt unmet needs in the relevant art, and which further every and all such present harming, damaging, inuring, insistent, insinuating, imposing, pestilent, impetuous, importune, pestiferous, condescending and insolent enthrallment, pretend, harass, engulf, press, presume, imprint, pester and oppress of innovative and panacean cutting-edge technological artistic utility and design solutions is undeniably, respectively, independently, autonomously, evidently, undeniably, logically, scientifically and intuitively hereby evinced as irrefutably insolent and unequivocally irresponsible on behalf of the ancient history vast network of intermediary carrier and/or broker aforementioned PUBLIC FINANCIALS™ organizations heretofore monopolizing every and all of the distinctively separate and traditionally exclusive speciality areas public accounting, transport management, investment banking and aforementioned PUBLIC FINANCIALS™ instruments entailing, encompassing, comprising, involving, impacting and/or effecting every and all real-time processing and/or reprocessing of data and/or information receiver content management, financial services and aforementioned PUBLIC FINANCIALS™ instruments transactional exchange initiatives, schemes, ocurrences, happenings, interactions, processes, methods, practices, movements, proceedings, messaging, presentations, notifications, filings, submissions, records, activities, actions, events, endeavors, tasks and affairs which occur, happen and/or transpire anywhere, anytime and anyplace within an aforementioned efficient UNIVERSAL CAPITAL MARKET™, and moreover to mitigate the exponentially augments of dangerours flirting with tempestuous diminishing returns on transactional exchanges, tempestuous diminishing returns on residual equities, tempestuous exponentially detrimental increases in systematic volatility and tempestuous exponentially debilitating increases of cost of capital on the treasure accounting, financial fueling and econometric energizing of members of the aforementioned UNIVERSAL POPULACE™ which operate and/or reside within, throughout and transcending the national sovereign borders of every and all of the industrialized, developed and developing free-market commerce and trade bloc economies throughout a single holistically econometric marketplace environment wherefrom hereto aforementioned UCMOST™ information technology is authentically and originally existent as a novel and unobvious conception technically engineered and artistically designed as a melioristic logical positivism and melodious development via consummate melioristic logical positivism devotional praxis and constructive reduction to practice.

### SUMMARY OF INVENTION

UNIFIED REAL-TIME MICROPROCESSOR COMPUTER, wherefrom hereto collectively innate conception, terminological conveyance, indivisible rubric, syntactic oralformulaic, unique artwork, systematic arrangement, differentiated crafting, artistic construct, melodious lyrics, denominative literateness and thereat proprietary multiport revolving chambered binary hunting metallic track encasing hermetic lock up cast casing aforementioned UCMOST™, heretofore formally utilized proprietary trademark and/or service mark exclusively owned intellectual property of Juan Carlos Castro, information technology concretize a novel, unobvious, unknown, unforeseen, unprecedented, epoch, paper-less, ease of use, fruitful, opportune, never faltering and never failing panacean cutting-edge breakthrough utility engineering and groundbreaking technological architectural design innovation which is a self-contained, fault-tolerant, anonymous, independent, autonomous, impartial, apolitical, streamlined, alternating scale, and inseparable, proprietary multiport revolving chambered homing binary hunting metallic track encasing hermetic data link caster dart castings constrained new software parallel redundancy cosmos robotizing unified real-time microprocessor machine language computer block whose universal dominion domain outline is comprehensively suitable, generally pertinent and broadly useful to whichever and whensonever, anytime, anyplace and anytime, hereafter naturally evincing and requisiting every and all, without limitation, conceived, created, engineered, designed, development, and hereto concretizing via consummate melioristic logical positivism devotional praxis and timely constructive reduction to practice, wherefrom hereto concretizing via consummate melioristic logical positivism devotional praxis and timely constructive reduction to practice innovatively novel, unknown, unforeseen and unprecedented real-time processing and/or reprocessing of data and/or information via continuous uptime steady state ubiquitous automatizing instantaneous real-time transmission and transport converter receiver conduit unified real-time microprocessing of UCMOST™ information technologies which are infinitely and unequivocally comprehensively suitable, generally pertinent and broadly useful to supplant every and all heretofore antiquated, archaic, ancient history and superannuated methods, techniques and preconceived notions of the following: retrieving; converting; formatting; processing; storing; gathering; compiling; tabulating; casting; calculating; preparing; editing; tracing; verifying; submitting; confirming; validating; booking; classifying; categorizing; adjusting; altering; revising; changing; billing; collecting; producing; composing; conducting; proofing; filtering; pressing; publishing; cataloging; indexing; scripting; locating; shooting; running; releasing; posting; compressing; presenting; releasing; playing; superannuated preconceived notions of the following: reretrieval; retransport; reconversion; reformatting; reprocessing; resaving; restoring; reidentifying; regathering; resorting; reorganizing; recompiling; retabulating; recasting; recalculating; repreparing; reediting; retracing; reverifying; resubmitting; reconfirming; revalidating; rebooking; reclassifying; recategorizing; readjusting; realtering; rerevising; rechanging; recharging, rebilling; recollecting, reproducing, recomposing; reconducting; reproofing; refiltering; repressing; republishing; recataloging; reindexing; rescripting; relocating; reshooting; rerunning; rereleasing; reposting; recompressing; representing rereleasing, replaying, redisplaying; reprojecting; rebroadcasting; resyndicating; wherefrom, hereto collectively innate conception, terminological conveyance, indivisible rubrical, syntactic oralformulaic, systematic arrangement, artistic construct, melodious lyrics, denominative literateness and thereat proprietary multiport revolving chambered hunting metallic track encasing hermetic new software lock up cast casing constrained real-time microprocessor engineering machine language unicore operating system software computing block keyhole combinational code heretofore and hereafter apprehends UCMOST™ real-time processing and/or reprocessing; proprietary trademark and service mark is exclusive proprietary intellectual property belonging exclusively and unequivocally to Juan Carlos Castro. Wherefrom hereto aforementioned UCMOST™ real-time processing and/or reprocessing automatizing real-time holistically steady state synchronized ubiquitous continuum sub-loculated cyclical parallel redundancy cosmos robotizing unified real-time microprocessor computer logic instructions propagating, promulgating and proclaiming universal dominion isomorphic domain rubricated pragmatic sanction across-the-board traversal of breakthrough technological and groundbreaking innovative developments and advancements in multifaceted and multidimensional microcosmic techniques, designs, systems, routines, devices, manners, modes, fashions, forms, formats, factors, objects, parts, segments, elements, components, constituents, ingredients, processes, methods and combinations; wherefrom moreover hereto entailing, encompassing, comprising, involving, impacting and/or effecting every and all automatizing real-time holistically steady state synchronized ubiquitous continuum sub-loculated cyclical parallel breakthrough technological and groundbreaking innovative developments and advancements in multifaceted and multidimensional microcosmic techniques, designs, systems, routines, devices, manners, modes, fashions, forms, formats, factors, objects, parts, segments, elements, components, constituents, ingredients, processes, methods and combinations; wherefrom moreover hereto entailing, encompassing, comprising, involving, impacting and/or effecting streamlined, alternating scale, inseparable, seamless and natural wrapping, interlacing, coiling, coupling, combining and interlocking every and all of the following: proprietary multiport revolving chambered homing binary hunting metallic track encasing hermetic data link caster dart castings constrained new end-user graphical human apostrophe interface syntactic synthesis real-time software programs block; proprietary multiport revolving chambered honing binary hunting metallic track encasing hermetic data link caster dart castings constrained new algebraic problem-solving application syntactic synthesis real-time software programs block; proprietary multiport revolving chambered homing binary hunting metallic track encasing hermetic data link caster dart castings constrained new robotizing gauge indicating guidance syntactic synthesis real-time software programs block; proprietary multiport revolving chambered homing binary hunting metallic track encasing hermetic data link caster dart castings constrained new commerce and transactional exchange methodology syntactic synthesis real-time software programs block; proprietary multiport revolving chambered homing binary hunting metallic track encasing hermetic data link caster dart castings constrained new commerce and trade languages combinatorial syntactic synthesis real-time software programs block; wherefrom every and all proprietary creative original conceptions, engineering utilities, aesthetic architectural designs, authentic compositions and genuine productions of a sole legal owner; wherefrom herewith concretizing consummate and constructive reduction to practice a complete sub-loculated cyclical parallel redundancy cosmos robotizing real-time microprocessor machine language logic instructing compact integrated new software generator AND-OR closed-circuitry wheresoever transcendent EPROM, degausse and/or magnetostriction preemptively constrained ferromagnetic alloy, silicon, germanium, biodynamic and/or geomagnetic resonant soundproof and fireclay wall protective fireball time holistically steady state synchronized ubiquitous continuum universal executive sub-compartment cyclical parallel redundancy cosmos robotizing real-time accurate, high-quality, never faulting, fully reliable, never failing, simplified and streamlined microprogrammable systematically codified microprocessor machine language logic instructions entailing, encompassing, comprising, involving, impacting and/or effecting every and all one-time programmable read-only memory (PROM) within a proprietary multiport revolving chambered homing binary hunting metallic track encasing hermetic data link caster dart castings constrained engine block protective contactor composite soundproof housing and fireclay sealed wall casting fireball impervious carriage data link caster dart castings accumulator controlling central processing unit (CPU) concretizing via conducive appendicular microelectronic templates appended, fixed, soldered, mounted, etched, embedded, copied, inscribed and/or contact printed onto every and all heretofore and hereafter mechanical and/or electrical devices, articles, apparatuses and/or megastructure microcircuit processing computing motherboards; wherefrom hereto intrinsic and integral as comprehensively suitable, generally pertinent and broadly useful within every and all automatizing high-quality holistically steady state heliocentrically synchronizing ubiquitous hunting continuum parallel redundancy cosmos robotizing unified real-time microprocessing computing protective contactor composite housing carriage devices, articles, apparatus, refractories and/or megastructures; wherefrom hereto successfully embroidering unequivocal absolute resolution proprietary revelatory cognizable relativistic relational melioristic logical positivism syntactic synthesis controlling central processing unit (CPU) fixture originating within every and all iota trace element minutia fueling and/or energizing microprocessor semi-conducting chips, whence perpetually propagating, promulgating and proclaiming galactic alternating angle conduit premised on a single alternating scale single independent portal proliferation of artificial semi-conducting microcircuit devices, articles, apparatuses, refractories and/or megastructures; wherefrom propagating traversal of every and all traditonal mechanical friction and/or chemical reaction to fuel power and energy conduit electrical and/or battery generation inclusive of every and all advanced electronic locational systematizing geological and/or seismological processes concretizing innovative wheresoever soundproof and fireclay wall protective fireball impervious microcircuit epoxy casting insulated permeability of artificial semi-conducting microcircuit devices, articles, apparatuses, refractories and/or megastructures internalizing upright orthorhombic tentacular boundless steady state roving antennule transmuting metric conversional transistor transfusing receiver concretizing high-quality holistically steady state heliocentrically synchronizing ubiquitous hunting continuum parallel redundancy cosmos robotizing digitalized galactic transmitting receiver of spatiotemporal emitted broadcasting of real-time microprocessing traversing a single independent portal refractory evincing minutia partible iota beta particle trace element wave front continuous spectrum pulse signaling transmission conveying efficient energizing and fueling powered catalytic conduits via electrogasdynamics, electrogenesis, electrohydraulic, geomagnetic, gyromagnetic, geokinetic and/or thermodynamic setting transistorized rheostat regulated transfusing partible trace element staple actualizing galactic and/or intergalactic gyroscopic axisymmetrical stabilizing self-impetus protective contactor composite housing carriage hermetic cast lock up software encased unified real-time microprocessor machine language computer block comprehensively suitable, generally pertinent and broadly useful within every and all portable rove bearing devices, articles, apparatuses and/or megastructures; wherefrom hereto collectively realizing optimized and efficient transport flow of every and all real-time processing and/or reprocessing of data and/or information receiver entailing, encompassing, comprising, involving, effecting and impacting every and all of the distinctively separate and traditionally exclusive specialty areas of holistically steady state continuous spectrum ubiquitous indistinguishably synchronous needs involving aforementioned UCMOST™ real-time processing and/or reprocessing of data and/or information content management, financial services and aforementioned PUBLIC FINANCIALS™ instruments transactional exchange initiatives, schemes, ocurrences, happenings, interactions, processes, methods, practices, movements, proceedings, messaging, presentations, notifications, filings, submissions, records, activities, actions, events, endeavors, tasks and affairs which evidently are legally, undeniably, logically, scientifically and intuitively entail, encompass, comprise, involve, effect and impact the treasure accounting, financial organizations respectively, independently, autonomously, evidently, undeniably, logically, scientifically and intuitively are hereto discovered to be inevitably necessary and increasingly integral living and breathing biological organisms within a capital market transmuting every and all multifaceted industries and multidimensional sectors of the industrialized, developed and developing free-market commerce and trade blocs within, throughout and transcending every and all whicever geographical territories of a single holistically econometric marketplace environment, wherefrom hereto every and all are hereby necessarily concretizing as streamlined, alternating scale, inseparable, seamless and naturally wrapped, twisted, convoluted, coupled and combined heretofore and hereafter as combinatorial with every and all, without limitation, of the following: so-called premature infants; so-called immature infants; so-called immature toddlers; so-called immature children; so-called immature child students; so-called immature adolescents; so-called immature adolescence students; so-called mature adults; so-called academic students; so-called independent writers; so-called independent bibliographers; so-called independent photographers; so-called independent editorial investigators; so-called independent editors; so-called independent reporters; so-called independent publishers so-called independent printmakers; so-called independent advertisers; so-called independent marketers; so-called independent manufacturers; so-called independent farmers; so-called independent owners; so-called independent labor personnel; so-called independent distributors; so-called independent resellers; so-called independent composers; so-called independent developers; so-called independent producers; so-called independent artists; so-called independent preachers; so-called independent philosophers; so-called independent inventors; so-called appointed managers; so-called elected mayors; so-called elected commissioners; so-called elected state congress representatives; so-called elected state congress senators; so-called elected state governors; so-called elected national congress representatives; so-called elected national congress senators; so-called elected national presidents; so-called elected jurisprudential district judges; so-called appointed jurisprudential state judges; so-called appointed jurisprudential circuit judges; so-called appointed jurisprudential national judges; so-called appointed national jurisprudential generals; so-called elected service commissioners; so-called appointed state civil service representatives; so-called appointed polity party bureaucratic officials; so-called civil service bureaucratic representatives; so-called civil service bureaucratic managers; so-called civil service correctional labor personnel; so-called civil service correctional representatives; so-called civil service correctional officials; so-called elected civil service jurisprudential investigative officials; so-called civil service commissioned jurisprudential investigative officers; so-called civil service commissioned jurisprudential investigative assistants; so-called independent commercial private correctional officers; so-called commercial private service investigators; so-called civil service rehabilitation representatives, so-called civil service rehabilitation managers; so-called civil service rehabilitation officials; so-called commercial rehabilitation representatives; so-called commercial rehabilitation managers; so-called commercial rehabilitation officials; so-called appointed civil service administrative wardens; so-called appointed commercial administrative wardens; so-called civil service labor personnel; so-called drafted military armed services labor personnel; so-called enlisted military armed services labor personnel; so-called enlisted military armed services non-commissioned personnel; so-called enlisted military armed services non-commissioned personnel correctional officers; so-called enlisted military armed services non-commissioned correctional wardens; so-called enlisted military armed services non-commissioned personnel rehabilitation officers; so-called enlisted military armed services non-commissioned personnel rehabilitation wardens; so-called enlisted military armed services non-commissioned rehabilitation pharmacologists; so-called enlisted military armed services noncommissioned medical physician doctors; so-called enlisted military armed services noncommissioned sergeants; so-called enlisted military armed services non-commissioned staff sergeants; so-called enlisted military armed services non-commissioned master staff sergeants; so-called military armed services commissioned lieutenant officers; so-called military armed services commissioned lieutenant commanders; so-called military armed services commissioned captain officers; so-called military armed services commissioned general officers; so-called military armed services Uniform Code of Military Justice (UCMJ); so-called military armed services commissioned jurisprudential investigators; associate professors; so-called tenured professors; so-called tenured jurisprudential scholars; so-called licensed jurisprudential practitioners; so-called tenured medical physician scholars; so-called licensed medical physician doctors; so-called accounting professor scholars; so-called certified accounting practitioners; so-called auditing professor scholars; so-called certified auditing practitioners; so-called commercial business professor scholars; so-called commercial business practitioners; so-called financing professor scholars; so-called financing practitioners; so-called scientists; so. called chemists; so-called physicists; so-called licensed psychologists; so-called licensed medical physician pschiatrists; so-called acknowledged associate pharmacists; so-called licensed pharmacologists; so-called unordained clericalists; so-called ordained clericalists; so-called politicking party members; so-called society inductees; so-called chamber representatives; so-called commercial service labor personnel; so-called consumers; so-called member-subscribers; so-called customers; so-called clients; so-called constituents; so-called debtors; so-called creditors; so-called shareholders; so-called stakeholders; so-called U.S. depositors; so-called U.S. citizen taxpayers; so-called foreign national depositors; so-called foreign national taxpayers; so-called princeship; so-called princesses; so-called dukes; so-called dukesses; so-called ambassadors; so-called diplomats; so-called monarchs; so-called global depositors; so-called domestic citizenry; so-called foreign citizenry; so-called domestic retiree citizenry; so-called foreign retiree citizenry; so-called general populace; wherefrom every and all, without limitation, of whom are also respectively, independently, autonomously, evidently, undeniably, logically, scientifically and intuitively found to be inevitably necessary and increasingly integral living and breathing biological organisms within a capital market heretofore and hereafter irrespective of whether whichever resides and/or operates heretofore and hereafter anytime, anywhere and anyplace within, throughout and/or transcending whichever geographical territories of a single holistically econometric marketplace environment, wherefrom moreover every and all whose inherent aim, letter, nature, breadth, sound, depth, spirit and scope herewith invokes, without limitation, across-the-board traversal of every and all of the hundreds of millions undeniably, evidentiary, logically, scientifically, intutively and necessarily depositors aforementioned UNIVERSAL POPULACE; irrespective of whichever private individuals, private and/or public commercial, labor unionized, religious sect, political ideological, group associational and/or public governance legal and/or status of existence above and below mentioned are undeniably, evidentiary, logically, scientifically and intuitively members of a universal citizenry, every and all of whom further, without limitation, are respectively, independently, autonomously, evidently, undeniably, logically, scientifically and intuitively found to be inevitably necessary and increasingly integral members of a capital market, heretofore and hereafter irrespective of whether whichever resides and/or operates anytime, anywhere and anyplace within, throughout and/or transcending whichever geographical territories of a single holistically econometric marketplace environment. Wherefrom terminological denominate syntactic synthesis invoking aforementioned UCMOST™ information technology is comprehensively suitable, generally pertinent and broadly useful to every and all, without limitation, aforementioned PUBLIC FINANCIALS instruments hereto harnessed, wrapped, leveraged and unequivocally apprehended in connection with every and all, without limitation, of the aforementioned PUBLIC FINANCIALS™ statements from every and all individual members of the aforementioned UNIVERSAL POPULACE™ which are heretofore and hereafter undeniably, logically, scientifically and intuitively comprehensively suitable, generally pertient and broadly useful to every and all real-time processing and/or reprocessing of data and/or information receiver entailing, encompassing, comprising, involving, impacting and/or effecting every and all asset, liability and residual equity ledger balance accounts of every and all private individuals inclusive, without limitation, of every and all public organizations within, throughout and transcending the national sovereign so-called borders of every and all of the industrialized, developed and developing free-market commerce and trade bloc economies within a single holistically econometric marketplace environment; wherefrom whichever further entailing, encompassing, comprising, involving, impacting and/or effecting every and all legal interstate and/or intrastrate Uniform Commercial Code (UCC), inclusive of legal transnational and/or transnational commercial mercantile free-trade agreements transcending national sovereign so-called borders of trade block mitigating every and all polarizing situations and/or unnecessary concerns involving: the Anti-Ballistic Misssle Treaty; the North American Free Trade Agreement (NAFTA); the European Economic Union (EEU); the Asian-Pacific Economic Community (APEC); wherefrom aforementioned PUBLIC FINANCIALS™ statements from every and all individual members of the aforementioned UNIVERSAL POPULACE™ which are heretofore and hereafter undeniably, logically, scientifically and intuitively comprehensively suitable, generally pertient and broadly useful to every and all real-time processing and/or reprocessing of data and/or information receiver entailing, encompassing, comprising, involving, impacting and/or effecting every and all ledger trace account, trial balance, cash flow, profit and loss and/or balance sheet; wherefrom whichever inherently, intrinsically, clearly, undeniably, logically, scientifically and intutively deriving and/or driving every and all personal financial statement inclusive of, without limitation, every and all public statement of revenue, cost of goods sold, depreciation expenditure, other operational expenditure, interest expenditure if applicable, taxes payable and/or deferred taxes payable, and residual profit if available, public statement of financial position or so-called public balance sheet, and public statement of cash flows inherently derived from every and all cash inflow and/or outflow from ledger account receivables, ledger account payables, acquisitions of property, plant, boiler and machinery equipment, ledger account short-term borrowing, ledger account long-term borrowing, new residual equity issuance and potential payment of dividends which occur, happen and/or transpire respectively from accounting, operating, exchanging, administrating, reconciling, managing and financing, inclusive of, without limitation, every and all distinctively separate and traditionally exclusive private and/or public off-balance sheet statement of financial position whichever owned as majority and/or minority participations, wherefrom further hereto every and all of which entail, encompass, comprise, involve, effect and impact every and all current and long-term ledger account asset receivable balances, ledger account asset Universal Character Set (UCS) and/or Universal Decimal System (UDS) driven and/or effectuated Universal Product Code (UPC) inventory balances, ledger account asset or potentially liability balances, ledger account other long-term asset balances, ledger account liability payable balances, ledger account structural capitalization residual equity balances, and other ledger account alternative structural capitalization residual equity balances, wherefrom further hereto every and all entail, encompass, comprise, involve, effect and impact every and all assets, liabilities and/or residual equities from private and/or public sub-unit, unit, divisional, segmented and/or consolidated elements, components, factors, constituents and ingredients comprising aforementioned PUBLIC FINANCIALS™ statements which inherently involve multifaceted and multidimensional non-financial account headings and non-financal contra-account headings entailing, encompassing, comprising, involving, impacting and/or effecting intrinsically and inherently, without limitation, every and all real-time processing and/or reprocessing of data and/or information receiver from every and all general populace, elected officials, appointed dignitaries, appointed diplomats, public/private organizations, sovereign government entities and/or not-for-profit organizations all of whom are respectively, independently, autonomously, evidently, undeniably, logically, scientifically and intuitively found to be inevitably necessary and increasingly integral member participants within a single holistically econometric marketplace environment. Every and all of the hundreds of millions of members of the aforementioned UNIVERSAL POPULACE, which heretofore is continuously subject to harming, damaging, inuring, insistent, insinuating, imposing, pestilent, impetuous, importune, pestiferous, condescending and insolent enthralling, hindering, entrapping, pretending, miring, fatiguing, maleficience, harassing, engulfing, pressing, malevolent, presuming, imprinting, malicious, suffocating, miring, strangling, repressing, entangling, pestering and oppressing within an aforementioned fragmenting capital market inefficiencies which lacks every and all techniques, designs, systems, routines, devices, manners, modes, fashions, forms, formats, factors, objects, parts, segments, elements, components, constituents, ingredients, processes, methods and combinations of panacean cutting-edge and innovative information technology entailing, encompassing, comprising, involving, impacting and/or effecting every and all basic functional elements, necessary interactions and integral transactional exchange initiatives, schemes, ocurrences, happenings, interactions, processes, methods, practices, movements, proceedings, messaging, presentations, notifications, filings, submissions, records, activities, actions, integrated streamlined, alternating scale, inseparable, seamless and natural wrapping, interlacing, coiling, coupling, combining and interlocking techniques, designs, systems, routines, devices, manners, modes, fashions, forms, formats, factors, objects, parts, segments, elements, components, constituents, ingredients, processes, methods and combinations entailing, encompassing, comprising, involving, impacting and/or effecting automatizing real-time holistically steady state synchronized ubiquitous continuum real-time rhombus microprocessing instantaneous transmission and receiver transforming traverse conduit aforementioned UCMOST™ real-time processing and/or reprocessing of public accounting, transport reconciling, independent auditing and financial reporting inclusive of efficient, effective, functional and integrated streamlined, alternating scale, inseparable, seamless and natural wrapping, interlacing, coiling, coupling, combining and interlocking techniques, designs, systems, routines, devices, manners, modes, fashions, forms, formats, factors, objects, parts, segments, elements, components, constituents, ingredients, processes, methods and combinations entailing, encompassing, comprising, involving, impacting and/or effecting automatizing real-time holistically steady state synchronized ubiquitous continuum real-time rhombus microprocessing instantaneous transmission and receiver transforming traverse conduit aforementioned UCMOST™ real-time processing and/or reprocessing order-entry quotation, matching, clearance, execution, settlement and exchange of insurance, risk financing, credit, cash management, investment banking and aforementioned PUBLIC FINANCIALS™ instruments transactional exchange initiatives, schemes, ocurrences, happenings, interactions, processes, methods, practices, movements, proceedings, messaging, presentations, notifications, filings, submissions, records, activities, actions, events, endeavors, tasks and affairs.

### OBJECTS AND ADVANTAGES

Accordingly, besides the main embodiments of my invention hereto submitted as a legal patent disclosure, the combinatorial conceptual realities of the wire jack line and/or wireless multifaceted and multidimensional communications heretofore exponentially unobvious, unknown, unforeseen, unprecedented, epoch, paper-less, ease of use, fruitful, opportune, never faltering and never failing panacean cutting-edge breakthrough utility engineering and groundbreaking technological architectural design innovative solution to resolve every and all basic functional elements and/or necessary interface transmission to concretize every and all transactional exchange initiatives, schemes, ocurrences, happenings, interactions, processes, methods, practices, movements, proceedings, messaging, presentations, notifications, filings, submissions, records, activities, actions, events, endeavors, tasks and affairs to whichever and whensonever, anytime, anyplace and anytime, hereafter naturally evincing and requisiting every and all, without limitation, conceived, created, engineered, designed, development, and hereto concretizing via consummate melioristic logical positivism devotional praxis and timely constructive reduction to practice a innovatively novel, unknown, unforeseen and unprecedented real-time processing of data and/or information receiver via continuous uptime steady state ubiquitous automatizing instantaneous real-time transmission and transport converter receiver conduit articles, apparatuses and/or megastructures; wherefrom hereto concretizing via consummate melioristic logical positivism devotional praxis and timely constructive reduction to practice innovatively novel, unknown, unforeseen and unprecedented real-time processing and/or reprocessing of data and/or information via continuous uptime steady state ubiquitous automatizing instantaneous real-time transmission and transport converter receiver conduit unified real-time microprocessing of UCMOST™ information technologies which are infinitely and unequivocally comprehensively suitable, generally pertinent and broadly useful to supplant every and all heretofore antiquated, archaic, ancient history and superannuated methods, techniques and preconceived notions of the following: retrieving; converting; formatting; processing; storing; gathering; compiling; tabulating; casting; calculating; preparing; editing; tracing; verifying; submitting; confirming; validating; booking; classifying; categorizing; adjusting; altering; revising; changing; billing; collecting; producing; composing; conducting; proofing; filtering; pressing; publishing; cataloging; indexing; scripting; locating; shooting; running; releasing; posting; compressing; presenting; releasing; playing; displaying; projecting; preconceived notions of the following: reretrieval; retransport; reconversion; reformatting; reprocessing; resaving; restoring; reidentifying; regathering; resorting; reorganizing; recompiling; retabulating; recasting; recalculating; repreparing; reediting; retracing; reverifying; resubmitting; reconfirming; revalidating; rebooking; reclassifying recategorizing; readjusting; realtering; rerevising; rechanging; recharging; rebilling; recollecting; reproducing; recomposing; reconducting; reproofing; refiltering; repressing; republishing; recataloging; reindexing; rescripting; relocating; reshooting; rerunning; rereleasing; reposting, recompressing: representing, rereleasing; replaying; redisplaying; reprojecting; rebroadcasting; resyndicating; wherefrom, hereto collectively innate conception, terminological conveyance, indivisible rubrical, syntactic oralformulaic, systematic arrangement, artistic construct, melodious lyrics, denominative literateness and thereat proprietary multiport revolving chambered hunting metallic track encasing hermetic new software lock up cast casing constrained real-time microprocessor engineering machine language unicore operating system software computing block keyhole combinational code heretofore and hereafter apprehends UCMOST™ real-time processing and/or reprocessing; proprietary trademark and service mark is exclusive proprietary intellectual property belonging exclusively and unequivocally to Juan Carlos Castro. Wherefrom hereto aforementioned UCMOST™ real-time processing and/or reprocessing automatizing real-time holistically steady state synchronized ubiquitous continuum sub-loculated cyclical parallel redundancy cosmos robotizing unified real-time microprocessor computer logic instructions propagating, promulgating and proclaiming universal dominion isomorphic domain rubricated pragmatic sanction across-the-board traversal of breakthrough technological and groundbreaking innovative developments and advancements in multifaceted and multidimensional microcosmic techniques, designs, systems, routines, devices, manners, modes, fashions, forms, formats, factors, objects, parts, segments, elements, components, constituents, ingredients, processes, methods and combinations; wherefrom moreover hereto entailing, encompassing, comprising, involving, impacting and/or effecting every and all of the tremendously long-held and enormously heart-felt unmet needs in the relevant art for which every and all whichever heretofore and hereafter tens of hundreds intuitively are hereto discovered to be inevitably necessary and increasingly integral living and breathing biological organisms within a capital market transmuting every and all multifaceted industries and multidimensional sectors of the industrialized, developed and developing free-market commerce and trade blocs within, throughout and transcending every and all whicever geographical territories of a single holistically econometric marketplace environment, wherefrom hereto every and all are hereby necessarily concretizing as streamlined, alternating scale, inseparable, seamless and naturally wrapped, twisted, convoluted, coupled and combined heretofore and hereafter as combinatorial with every and all, without limitation, of the following: so-called premature infants; so-called immature infants, so-called immature toddlers; so-called immature children; so-called immature child students; so-called immature adolescents; so-called immature adolescence students; so-called mature adults; so-called academic students; so-called independent writers; so-called independent bibliographers; so-called independent photographers; so-called independent editorial investigators; so-called independent editors; so-called independent reporters; so-called independent publishers; so-called independent printmakers; so-called independent advertisers; so-called independent marketers; so-called independent manufacturers; so-called independent farmers; so-called independent owners; so-called independent labor personnel; so-called independent distributors; so-called independent resellers; so-called independent composers; so-called independent developers, so-called independent producers; so-called independent artists; so-called independent preachers; so-called independent philosophers; so-called independent inventors; so-called appointed managers; so-called elected mayors; so-called elected commissioners; so-called elected state congress representatives; so-called elected state congress senators; so-called elected state governors; so-called elected national congress representatives; so-called elected national congress senators; so-called elected national presidents; so-called elected jurisprudential district judges; so-called appointed jurisprudential state judges; so-called appointed jurisprudential circuit judges; so-called appointed jurisprudential national judges; so-called appointed national jurisprudential generals; so-called elected state jurisprudential generals; so-called appointed national civil service commissioners; so-called appointed bureaucratic officials; so-called civil service bureaucratic representatives; so-called civil service bureaucratic managers; so-called civil service correctional labor personnel; so-called civil service correctional representatives; so-called civil service correctional officials; so-called elected civil service jurisprudential investigative officials; so-called civil service commissioned jurisprudential investigative officers; so-called civil service commissioned jurisprudential investigative assistants; so-called independent commercial private correctional officers; so-called commercial private service investigators; so-called civil service rehabilitation representatives; so-called civil service rehabilitation managers; so-called civil service rehabilitation officials; so-called commercial rehabilitation representatives; so-called commercial rehabilitation managers; so-called commercial rehabilitation officials; so-called appointed civil service administrative wardens; so-called appointed commercial administrative wardens; so-called civil service labor personnel; so-called drafted military armed services labor personnel; so-called enlisted military armed services labor personnel; so-called enlisted military armed services non-commissioned personnel; so-called enlisted military armed services noncommissioned personnel correctional officers; so-called enlisted military armed services noncommissioned correctional ward en s; so-called enlisted military armed services noncommissioned personnel rehabilitation officers; so-called enlisted military armed services non-commissioned personnel rehabilitation wardens; so-called enlisted military armed services non-commissioned rehabilitation pharmacologists; so-called enlisted military armed services non-commissioned medical physician doctors; so-called enlisted military armed services non-commissioned sergeants; so-called enlisted military armed services non-commissioned staff sergeants; so-called enlisted military armed services non-commissioned master staff sergeants; so-called military armed services commissioned lieutenant officers; so-called military armed services commissioned lieutenant commanders; so-called military armed services commissioned captain officers; so-called military armed services commissioned general officers; so-called military armed services Uniform Code of Military Justice (UCMJ); so-called military armed services commissioned jurisprudential investigators; so-called military armed services commissoned jurisprudential practicioners; so-called acknowledged assistant jurisprudential practitioners; so-called tenured medical physician scholars; so-called licensed medical physician doctors; so-called accounting professor scholars; so-called certified accounting practitioners; so-called auditing professor scholars; so-called certified auditing practitioners; so-called commercial business professor scholars; so-called commercial business practitioners; so-called financing professor scholars; so-called financing practitioners; so-called scientists; so-called chemists; so-called physicists; so-called licensed psychologists; so-called licensed medical physician pschiatrists; so-called acknowledged associate pharmacists, so-called licensed pharmacologists; so-called unordained clericalists; so-called ordained clericalists; so-called politicking party members; so-called society inductees; so-called chamber representatives; so-called commercial service labor personnel; so-called consumers; so-called member-subscribers; so-called customers; so-called clients; so-called constituents; so-called debtors; so-called creditors; so-called shareholders; so-called stakeholders; so-called U.S. depositors; so-called U.S. citizen taxpayers; so-called foreign national depositors; so-called foreign national taxpayers; so-called princeship; so-called princesses; so-called dukes; so-called dukesses; so-called ambassadors; so-called diplomats; so-called monarchs; so-called global depositors; so-called domestic citizenry; so-called foreign citizenry; so-called domestic retiree citizenry; so-called foreign retiree citizenry; so-called general populace; wherefrom every and all, without limitation, of whom are also respectively, independently, autonomously, evidently, undeniably, logically, scientifically and intuitively found to be inevitably necessary and increasingly integral living and breathing biological organisms within a capital market heretofore and hereafter irrespective of whether whichever resides and/or operates heretofore and hereafter anytime, anywhere and anyplace within, throughout and/or transcending whichever geographical territories of a single holistically econometric marketplace environment, wherefrom moreover every and all whose inherent aim, letter, nature, breadth, sound, depth, spirit and scope herewith invokes, without limitation, across-the-board traversal of every and all of the hundreds of millions undeniably, evidentiary, logically, scientifically, intutively and necessarily depositors inclusive of undeniably, evidentiary, logically, scientifically, intutively and necessarily investors, individuals, private and/or public commercial, labor unionized, religious sect, political ideological, group associational and/or public governance legal and/or status of existence above and below mentioned are undeniably, evidentiary, logically, scientifically and intuitively members of a universal citizenry, every and all of whom further, without limitation, are respectively, independently, autonomously, evidently, undeniably, logically, scientifically and intuitively found to be inevitably necessary and increasingly integral members of a capital market, heretofore and hereafter irrespective of whether whichever resides and/or operates anytime, anywhere and anyplace within, throughout and/or transcending whichever geographical territories of a single holistically econometric marketplace environment, wherefrom hereto innate conception, terminological conveyance, indivisible rubric, syntactic oralformulaic, unique artwork, systematic arrangement, differentiated crafting, artistic construct, melodious lyrics, denominative literateness and thereat proprietary multiport revolving chambered binary hunting metallic track encasing hermetic lock up cast casing constrained unified real-time microprocessor machine language object block keyhole combinational software computer code heretofore and hereafter above and below mentioned individual members of the aforementioned UNIVERSAL POPULACE™, proprietary trademark and service mark is exclusive proprietary intellectual property belonging exclusively and unequivocally to Juan Carlos Castro. Every and all of the hundreds of millions of members of the aforementioned UNIVERSAL POPULACE, plead and yearn for invoking assize involving hereto specifications of objections and advantages comprehensively suitable, generally pertinent and broadly useful as specification, logical and scientific machine code object real-time microprocessor to supplant, without limitation, every and all, whereas, it is clearly an undeniable and evidentiary findings of fact, documented reference, logical scientific deduction and intuitive analytical reasoning that aforementioned UCMOST™ information technology supplants every and all of the heretofore unaddressed and unresolved tremendously long-held and enormously heart-felt unmet needs in the relevant art which have risen as a consequence of the proliferation of telecommunications techniques inclusive of, without limitation, every and all inefficient, portentous, menacing, presumptuous and fruitless so-called wire jack line and/or wireless batch transmission of data and/or information to/from receivers to communicate across short and long-distances alike via time-lagged, hesitant, holding, delayed, imprudent, detrimental and debilitating methodologies via antiquated, archaic, ancient history and superannuated methodologies of identifying, organizing, cataloging, indexing, categorizing, processing and thereupon deriving every and all collections of featured, displayed, projected and/or presented literary, theatrical, melodious and/or aesthetic works involving every and all presumptuous, portentous, pretentious, pernicious, antiquated, archaic, ancient history and superannuated disparate and/or compressible digitalized artistic, theatrical, logic, heurisitc, inference, charactery, numeric, literary, melodius, auditory and video data transport control processing format protocols broadcasting, distributing and/or syndicating transmission and/or rebroadcasting, redistributing and/or resyndicating time-lagged spooling and/or batch processing transmission to/from converting receiver inclusive of, without limitation, every and all so-called apostrophe applications inclusive of all the following: whereas so-called windows operating system (WINDOWS) computing graphical software programs; whereas, so-called beginner's all-purpose symbolic instruction code (BASIC) microcomputing languages applications software programs; whereas, so-called disk operating system (MS-DOS) computing operating system software programs, whereas, so-called windows (Media Player) streaming applications computing software programs; whereas, so-called extensible mark-up (XML) seamless linkage interconnect software computing programs; whereas, so-called standard operating applications programs (SOAP) seamless linkage interconnect software computing systems; whereas, so-called dewey decimal system (DEWEY) disparate and/or integrated charactery and numismatic format processing software computing programs; whereas, so-called Movie Pictures Experts Group (MPEG-4) streaming applications computing software programs; whereas, so-called (MP3) streaming digitalized auditory applications computing software programs; whereas, so-called (Plug-and-Play) wire jack line and/or wireless modem driven streaming applications computing software programs; so-called (Real Player) streaming applications computing software programs; whereas, so-called unisys (UUNET) disparate charactery and numismatic format processing software computing situated (META) disparate charactery and numismatic format processing software computing programs; whereas, so-called common business oriented languages (COBOL), so-called common microcomputing languages (C: C+: C++): whereas, so-called high level programming algebraic problem-solving languages (FORTRAN); whereas, so-called linux open-source (LIN computing software programs; whereas, so-called programming in logic (PROLOG) computing software programs; whereas, so-called toddler, children and/or adolescent educational programming (LOGO) computing software application programs; whereas, so-called defense emergency final contact operating network (DEFCON) computing systems and/or computing software programs; whereas, so-called global positioning system (GPS) computing software programs; whereas, so-called oracle financial application (ORACLE) computing software programs; whereas, so-called linux open-source (LINUX) computing operating systems; so-called superannuated basic input/output systems (BIOS) microcomputing language applications software programs; whereas, so-called interfacing open source foundational java (JAVA) streaming computing software programs; whereas, so-called human apostrophe peer-to-peer and business-to-business so-called open source foundational jxta (JXTA) streaming computing software programs; whereas, so-called human apostrophe interfacing (AOL) streaming applications computing software programs; whereas, so-called International Standard Book Number (ISBN) disparate and/or integrated charactery and numismatic format processing software computing programs; whereas, so-called electronic data processing (EDP) disparate and/or integrated charactery and numismatic format processing software computing programs, whereas, so-called just-in-time (JIT) inventory management tracking software computing programs routing and updating methodologies; whereas, so-called activity-based-cost (ABC) inventory management charactery and/or numeric spreadsheet driven software computing programs; so-called ethernet and/or local area network network management switching software processing computing programs; whereas, so-called portfolio asset class allocation (EnCORR) selection and analysis software computing programs; so-called portfolio asset class allocation (EnCORR) optimizing and efficient frontier analyticalsoftware computing programs; so-called electronic money, banking and/or tax preparation and collection (QUICKEN) software computing programs interfacing methodologies; whereas, so-called Internet file transport protocol (FTP) software computing methodologies; whereas, so-called Internet go for (GOPHER) software computing methodologies; whereas, so-called Internet hyper-text transport protocol (HTTP) widely recognized and speciuosly registered .com, .net., org., .edu, .gov, and cc interaccessible software computing programs interfacing methodologies; whereas, so-called extracellular and/or extracorporeal wireline and wireless multiplexed apostrophe electrograph, electrostatic, electrothermal, photographic, xerographic, thermographic, thermostatic, thermoelectric, telecast, teletext, teletype, televise, telefacsimile, telegraphy, telemetry, telephony, frame-relay wireline; fixtured wireline, sporadic wire, cable, fiber, film, optic, glass, infrared, radio, television, projection, cinema, radar and/or artificial satellite network storage and/or routing software processing computing programs; whereas, so-called domain name suffix ending labeled universal reference languages (URL) access locational and reference directional interaccessaible software computing programs interfacing methodologies; whereas, so-called world wide web (WWW) internetwork data routing interaccessible software computing programs interfacing methodologies; whereas, so-called hyper-text messaging language (HTML) page formatting interaccessaible software computing programs interfacing methodologies; whereas, so-called wide area network and/or wireless applications programmed (WAP) network management switching; whereas, so-called bluetooth (BLUETOOTH) interoperable computing software programs; whereas, so-called Peripheral Component Interconnect (PCI) interoperable serial busing applications software computing programs; whereas, so-called 802.11 (IEEE) wireless local area (WAN) and/or local area network (LAN) streaming applications computing software programs; whereas, so-called 802.11b (IEEE) wireless high-frequency streaming applications computing software programs; whereas, so-called macintoch (QuickTime) streaming applications computing software programs; whereas, so-called macintoch (MAC) computing operating system graphical software programs; whereas, so-called macintoch disk operating system (MAC) computing graphical software programs; wherefrom evincing every and all antiquated, archaic, ancient history and superannuated methodological pooling and/or batch transmission software programs effecting various multidimensional boisterous, pretentious, portentous and pretentious proliferation of the disparate utilization of obscurant, irresponsible, feculent, irrational, feckless, disrespectful, mendacious, ignorant, malicious, condescending, untruthful, insolent, inefficient, incognizant, ineffective, fragmenting, unlettered, unpolished, presumptuous, portentous, pretentious, fruitless, antiquated, archaic, ancient history and superannuated software programs, hardcore computing operating systems, telecommunications and/or telemetry routing and switching infrastructure, personal and/or scalable enterprise network software computing devices, inclusive of, without limitation, every and all hardware computing manufacture of components, factors, constituents, components, ingredients, articles, artifices and/or peripherals heretofore incorrectly preconceived as comprehensively suitable, generally pertient and broadly useful to whichever, whereever and whenever; and whence, wherefrom evincing every and all feculent, feckless, inefficient, portentous, fruitless, antiquated, archaic, ancient history and superannuated real-time processing and/or reprocessing of data and/or information receiver of every and all, without limitation, inclusive of. feculent, feckless, ineffective, presumptuous, fragmented, antiquated, archaic, ancient history and superannuated dot matrix printing instrument processing; feculent, feckless, ineffective, presumptuous, fragmented, antiquated, archaic, ancient history and superannuated daizy wheel printing instrument processing; antiquated, archaic and ancient hisotry ink jet; feculent, feckless, ineffective, presumptuous, fragmented, antiquated, archaic, ancient history and superannuated laser printing instrument processing; wireless portable personal digital assistants instrument processing; wireless portable personal tablet laptop instrument processing; wireless portable wide area network combined with local area network routing and switcing management access manual and/or automatizing telephone instrument processing; portable standalone and portable fixtured manual pre-pay and/or automated pre-paid calling card telephone instrument processing; fixtured standalone and carrier fixtured manual pre-pay and/or automated pre-paid calling card telephone instrument processing; portable standalone and portable fixtured automatizing keystroke board instrument processing; fixtured standalone and carrier fixtured automatizing keystroke board instrument processing; portable standalone and portable fixtured portable fixtured automatizing touchstroke board instrument processing; fixtured standalone and carrier fixtured automatizing touchstroke board instrument processing, portable standalone and portable fixtured automatizing touchstroke pad instrument processing; fixtured standalone and carrier fixtured automatizing touchstroke pad instrument processing, portable standalone and portable fixtured automatizing auditory-stroke board instrument processing; fixtured standalone and carrier fixtured automatizing auditory-stroke board instrument processing; portable standalone and portable fixtured automatizing auditory-stroke pad instrument processing; fixtured standalone and carrier fixtured automatizing auditory-stroke pad instrument processing; portable standalone and portable fixtured automatizing remote activated radar-stroke board instrument processing; fixtured standalone and carrier fixtured automatizing remote activated radar-stroke board instrument processing; portable standalone and portable fixtured automatizing remote activated radar-stroke pad instrument processing; fixtured standalone and carrier fixtured automatizing remote activated radar-stroke pad instrument processing; portable standalone and portable fixtured automatizing remote activated airliner warning and control system traffic instrument processing; fixtured standalone and carrier fixtured automatizing remote activated airliner warning and control system traffic instrument processing; portable standalone and portable fixtured automatizing remote activated airborne warning and control system surveillance instrument processing; fixtured standalone and carrier fixtured automatizing remote activated airborne warning and control system surveillance instrument processing; portable standalone and portable fixtured automatizing remote activated airborne electronic grounding information system surveillance instrument processing; fixtured standalone and carrier fixtured automatizing remote activated airborne electronic grounding information system surveillance instrument processing; further inclusive of, without limitation: portable standalone and portable fixtured automatizing telephone instrument processing; fixtured standalone and carrier fixtured automatizing telephone instrument processing; portable standalone and portable fixtured automatizing public access call box telephone instrument processing; fixtured standalone and carrier fixtured automatizing public access call box telephone instrument processing; portable standalone and portable fixtured automatizing facsimile instrument processing; fixtured standalone and carrier fixtured automatizing vending instrument processing; portable standalone and portable fixtured spatiotemporal automated teller instrument processing; fixtured standalone and carrier fixtured spatiotemporal automated teller instrument processing; portable standalone and portable fixtured spationtemporal manual and/or automatizing gasoline service station fueling, upkeep and/or repair instrument processing; fixtured standalone and carrier fixtured spatiotemporal manual and/or automatizing gasoline service station fueling, upkeep and/or repair instrument processing portable standalone and portable fixtured spationtemporal manual and/or automatizing broadcasting transmission iota minutia ionizing fuel and energy instrument processing; fixtured standalone and carrier fixtured spatiotemporal manual and/or automatizing broadcasting transmission iota minutia ionizing fuel and energy instrument processing; wherefrom further every and all, without limitation, of the vast numbers of spatiotemporal and geologistical: portable standalone and portable building fixture spatiotemporal manual and/or automatizing legal-trial court research reviewing instrument processing; fixtured standalone and building fixture spatiotemporal manual and/or automatizing legal-trial court research reviewing instrument processing; portable standalone and portable building fixture spatiotemporal manual and/or automatizing legal-trial court support advisory instrument processing; fixtured standalone and building fixture spatiotemporal manual and/or automatizing legal-trial court support advisory instrument processing; portable standalone and portable building fixture spatiotemporal manual and/or automatizing legal-trial court briefing writ of ceast-and-desist filing instrument processing; fixtured standalone and building fixture spatiotemporal manual and/or automatizing legal-trial court briefing writ of ceast-and-desist filing instrument processing; portable standalone and portable building fixture spatiotemporal manual and/or automatizing legal-trial court briefing writ of sequestration filing instrument processing; fixtured standalone and building fixture spatiotemporal manual and/or automatizing legal-trial court briefing writ of sequestration filing instrument processing; portable standalone and portable building fixture spatiotemporal manual and/or automatizing legal-trial court briefing writ of injunction filing instrument processing; fixtured standalone and building fixture spatiotemporal manual and/or automatizing legal-trial court briefing writ of prohibition filing instrument processing; fixtured standalone and building fixture spatiotemporal manual and/or automatizing legal-trial court briefing writ of prohibition filing instrument processing; portable standalone and portable building fixture spatiotemporal manual and/or automatizing legal-trial court briefing writ of habeas corpus filing instrument processing; fixtured standalone and building fixture spatiotemporal manual and/or automatizing legal-trial court briefing writ of habeas corpus filing instrument processing; portable standalone and portable building fixture spatiotemporal manual and/or automatizing legal-trial court briefing writ of summons filing instrument processing; fixtured standalone and building fixture spatiotemporal manual and/or automatizing legal-trial court briefing writ of summons filing instrument processing; portable standalone and portable building fixture spatiotemporal manual and/or automatizing legal-trial court briefing writ of error filing instrument processing; fixtured standalone and building fixture spatiotemporal manual and/or automatizing legal-trial court briefing writ of error filing instrument processing; portable standalone and portable building fixture spatiotemporal manual and/or automatizing legal-trial court briefing writ of election filing instrument processing; fixated standalone and building fixture spatiotemporal manual and/or automatizing legal-trial court briefing writ of election filing instrument processing; portable standalone and portable building fixture spatiotemporal manual and/or automatizing legal-trial court subpeona pre-trial discovery instrument processing; fixtured standalone and building fixture spatiotemporal manual and/or automatizing legal-trial court subpeona pre-trial discovery instrument processing; portable standalone and portable building fixture spatiotemporal manual and/or automatizing legal-trial court subpeona pre-trial deposition instrument processing; fixtured standalone and building fixture spatiotemporal manual and/or automatizing legal-trial court subpeona pre-trial deposition instrument processing; portable standalone and portable building fixture spatiotemporal manual and/or automatizing legal-trial court object argument proceeding instrument processing; fixtured standalone and building fixture spatiotemporal manual and/or automatizing legal-trial court object argument proceeding instrument processing; portable standalone and portable building fixture spatiotemporal manual and/or court summary adjudication instrument processing; portable standalone and portable building fixture spatiotemporal manual and/or automatizing legal-trial court jury peer findings and adjudication instrument processing; fixtured standalone and building fixture spatiotemporal manual and/or automatizing legal-trial court jury peer findings and adjudication instrument processing; portable standalone and portable building fixture spatiotemporal manual and/or automatizing legal-appellate court research reviewing instrument processing; fixtured standalone and building fixture spatiotemporal manual and/or automatizing legal-appellate court research reviewing instrument processing; portable standalone and portable building fixture spatiotemporal manual and/or automatizing legal-appellate court support advisory instrument processing fixtured standalone and building fixture spatiotemporal manual and/or automatizing legal-appellate court support advisory instrument processing; portable standalone and portable building fixture spatiotemporal manual and/or automatizing legal-appellate court briefing writ habeas corpus filing instrument processing; fixtured standalone and building fixture spatiotemporal manual and/or automatizing legal-appellate court briefing writ habeas corpus filing instrument processing; portable standalone and portable building fixture spatiotemporal manual and/or automatizing legal-appellate court subpeona pre-trial discovery instrument processing; fixtured standalone and building fixture spatiotemporal manual and/or automatizing legal-appellate court subpeona pre-trial discovery instrument processing; portable standalone and portable building fixture spatiotemporal manual and/or automatizing legal-appellate court subpeona pre-trial deposition instrument processing; fixtured standalone and building fixture spatiotemporal manual and/or automatizing legal-appellate court subpeona pre-trial deposition instrument processing; portable standalone and portable building fixture spatiotemporal manual and/or automatizing legal-appellate court trial object argument proceeding instrument processing; fixtured standalone and building fixture spatiotemporal manual and/or automatizing legal-appellate court trial object argument proceeding instrument processing; portable standalone and portable building fixture spatiotemporal manual and/or automatizing legal-appellate court trial judge summary adjudication instrument processing; fixtured standalone and building fixture spatiotemporal manual and/or and/or automatizing legal-appellate court trial judge findings and adjudication instrument processing; fixtured standalone and building fixture spatiotemporal manual and/or automatizing legal-appellate court trial judge findings and adjudication instrument processing; portable standalone and portable building fixture spatiotemporal manual and/or automatizing legal-supreme court research reviewing instrument processing; fixtured standalone and building fixture spatiotemporal manual and/or automatizing legal-supreme court research reviewing instrument processing; portable standalone and portable building fixture spatiotemporal manual and/or automatizing legal-supreme court support advisory instrument processing; fixtured standalone and building fixture spatiotemporal manual and/or automatizing legal-supreme court support advisory instrument processing; portable standalone and portable building fixture spatiotemporal manual and/or automatizing legal-supreme court briefing writ habeas corpus filing instrument processing; fixtured standalone and building fixture spatiotemporal manual and/or automatizing legal-supreme court briefing writ habeas corpus filing instrument processing; portable standalone and portable building fixture spatiotemporal manual and/or automatizing legal-supreme court subpeona pre-trial discovery instrument processing, fixtured standalone and building fixture spatiotemporal manual and/or automatizing legal-supreme court subpeona pretrial discovery instrument processing; portable standalone and portable building fixture spatiotemporal manual and/or automatizing legal-supreme court subpeona pre-trial deposition instrument processing; fixtured standalone and building fixture spatiotemporal manual and/or automatizing legal-supreme court subpeona pre-trial deposition instrument processing; portable standalone and portable building fixture spatiotemporal manual and/or automatizing legal-supreme court trial object argument proceeding instrument processing; fixtured standalone and building fixture spatiotemporal manual and/or automatizing legal-supreme court trial object argument proceeding instrument processing; portable standalone and portable building fixture spatiotemporal manual and/or automatizing legal-supreme court trial judge summary adjudication instrument processing; fixtured standalone and building fixture spatiotemporal manual and/or automatizing legal-supreme court trial judge summary adjudication instrument processing; portable standalone and building fixture spatiotemporal manual and/or automatizing legal-supreme court trial judge findings and adjudication instrument processing; and moreover, wherefrom every and all, without limitation, of the vast numbers of spatiotemporal and geologistical: portable standalone and portable building fixture spatiotemporal manual and/or automatizing in-patient and/or out-patient medical admission, trasporting, release, tracking and multivendor billing and collection instrument processing; fixtured standalone and building fixture spatiotemporal manual and/or automatizing in-patient and/or out-patient medical admission, trasporting, release, tracking and multivendor billing and collection instrument processing; portable standalone and portable building fixtue spatiotemporal manual and/or automatizing in-patient and/or out-patient life-support medicine instrument processing; fixtured standalone and building fixture spatiotemporal manual and/or automatizing in-patient and/or out-patient life-support medicine instrument processing; portable standalone and portable building fixture spatiotemporal in-patient and/or out-patient preventative medicine consult instrument processing; fixtured standalone and building fixture spatiotemporal manual and/or automatizing in-patient and/or out-patient preventative medicine consult instrument processing; portable standalone and portable building fixture spatiotemporal in-patient and/or out-patient emergency medicine trauma instrument processing; fixtured standalone and building fixture spatiotemporal in-patient and/or out-patient emergency medicine trauma instrument processing; fixtured standalone and space less building fixture spatiotemporal in-patient and/or out-patient preventative elective medicine consult instrument processing; fixtured standalone and space less building fixture spatiotemporal in-patient and/or out-patient preventative elective medicine consult instrument processing; portable standalone and portable building fixture spatiotemporal in-patient and/or out-patient specialty medicine consult instrument processing, fixtured standalone and building fixture spatiotemporal in-patient and/or out-patient specialty medicine consult instrument processing; portable standalone and portable building fixture spatiotemporal in-patient and/or out-patient operational surgical medicine instrument processing; fixtured standalone and building fixture spatiotemporal in-patient and/or out-patient operational surgical medicine instrument standalone and building fixture spatiotemporal in-patient and/or out-patient neurological surgical medicine instrument processing; portable standalone and portable building fixture spatiotemporal in-patient and/or out-patient pathological medicine instrument processing; fixtured standalone and building fixture spatiotemporal in-patient and/or outpatient pathological medicine instrument processing; portable standalone and portable building fixture spatiotemporal in-patient and/or out-patient cardiological medicine instrument processing; fixtured standalone and building fixture spatiotemporal in-patient and/or out-patient cardiological medicine instrument processing; portable standalone and portable building fixture spatiotemporal in-patient and/or out-patient urological trace element medicine instrument processing; fixtured standalone and building fixture spatiotemporal in-patient and/or out-patient urological trace element medicine instrument processing; portable standalone and portable building fixture spatiotemporal in-patient and/or out-patient radiological plate and film xerographic medicine instrument processing; fixtured standalone and building fixture spatiotemporal in-patient and/or outpatient radiological plate and film xerographic medicine instrument processing; portable standalone and portable building fixture spatiotemporal in-patient and/or out-patient chemoradiology medicine instrument processing; fixtured standalone and building fixture spatiotemporal in-patient and/or out-patient chemoradiology medicine instrument processing; portable standalone and portable building fixture spatiotemporal in-patient and/or out-patient physiological medicine instrument processing; fixtured standalone and building fixture spatiotemporal in-patient and/or out-patient physiological medicine instrument processing; portable standalone and portable building fixture spatiotemporal in-patient and/or out-patient biological medicine instrument processing; fixtured standalone and building fixture spatiotemporal in-patient and/or out-patient biological medicine instrument processing; portable standalone and portable building fixture spatiotemporal in-patient and/or out-patient cytogenetic medicine instrument processing; fixtured standalone and building fixture spatiotemporal in-patient and/or out-patient cytogenetic medicine instrument processing; portable standalone and portable building fixture spatiotemporal in-patient and/or out-patient fertility medicine instrument processing; fixtured standalone and building fixture spatiotemporal in-patient and/or out-instrument processing; fixtured standalone and building fixture spatiotemporal in-patient and/or out-patient preventative medicine instrument processing; portable standalone and portable building fixture spatiotemporal in-patient and/or out-patient alternative medicine instrument processing; fixtured standalone and building fixture spatiotemporal in-patient and/or out-patient alternative medicine instrument processing; portable standalone and portable building fixture spatiotemporal in-patient and/or out-patient psychological preventative medicine instrument processing; fixtured standalone and building fixture spatiotemporal in-patient and/or out-patient psychological preventative medicine instrument processing; portable standalone and portable building fixture spatiotemporal in-patient and/or out-patient psychological rehabilitative medicine instrument processing, fixtured standalone and building fixture spatiotemporal in-patient and/or out-patient psychological rehabilitative medicine instrument processing; portable standalone and portable building fixture spatiotemporal in-patient and/or out-patient surgical recovery medicine instrument processing; fixtured standalone and building fixture spatiotemporal in-patient and/or out-patient surgical recovery medicine instrument processing; portable standalone and portable building fixture spatiotemporal in-patient and/or out-patient physical rehabilitation medicine instrument processing; fixtured standalone and building fixture spatiotemporal in-patient and/or out-patient physical rehabilitation recovery medicine instrument processing; portable standalone and portable building fixture spatiotemporal home health care medicine instrument processing; fixtured standalone and building fixture spatiotemporal home health care medicine instrument processing; portable standalone and portable building fixture spatiotemporal hospice care medicine instrument processing; fixtured standalone and building fixture spatiotemporal hospice care medicine instrument processing; portable standalone and portable building fixture spatiotemporal prescription drug ordering, filling, distribution and reodering, refilling, transport redistribution inclusive of billing and collection instrument processing; fixtured standalone and building fixture spatiotemporal prescription drug ordering, filling, distribution and reodering, refilling, transport redistribution inclusive of billing and collection instrument processing; portable standalone and portable building fixture spatiotemporal major medical orthopedic surgical instrument processing; fixtured major medical orthoscopic surgical instrument processing; fixtured standalone and building fixture spatiotemporal major medical orthoscopic surgical instrument processing; portable standalone and portable building fixture spatiotemporal major medical dental surgical instrument processing; fixtured standalone and building fixture spatiotemporal major medical dental surgical instrument processing; portable standalone and portable building fixture spatiotemporal major medical vision surgical instrument processing; fixtured standalone and building fixture spatiotemporal major medical vision surgical instrument processing; portable standalone and portable building fixture spatiotemporal proprietary and/or group office preventative medical consult multiport invoice billing and collection instrument processing; fixtured standalone and building fixture spatiotemporal proprietary and/or group office preventative medical consult -multiport invoice billing and collection instrument processing; and wherefrom further every and all, without limitation, of the vast numbers of spatiotemporal and geologistical: portable standalone and portable building fixture spatiotemporal personal and/or commercial insurance auditory and spontaneous real-estate inspection tangible property assessment and verification instrument processing; fixtured standalone and building fixture spatiotemporal personal and/or commercial insurance auditory and spontaneous real-estate inspection tangible property assessment and verification instrument processing; inclusive of every and all, without limitation, income, capital gains, taxes, charitable contribution, endowment, foundation, inheritance, transactional, estate and/or social security entitlement automated teller machine and/or so-called electronic deposit, withdrawing, transporting, letter of crediting, equity lines, credit lines, revolving credit lines, credit cards, debit cards, prepaid debit cards, check draft cards, certified check drafting, traveling check drafting, merchant, commercial, retail and/or mortgage banking, securities and insurance instrument processing; inclusive of, without limitation, every and all variant fixed and portable wire-less and wire jack line pre-paid telephony cards and/or services services wherefrom every and all are heretofore antiquated, archaic, ancient history and superannuated methodologies and processing techniques proliferating so-called telecommunications among depositors in locale and transcontinental fashion in an effort at further propagating boisterous, bolstering, voracious, raptorial, pretentious, and hereto notwithstanding, wherefrom it is clearly an undeniable and evidentiary findings of fact, documented reference, logical scientific deduction and intuitive analytical reasoning that within the heretofore highly dynamic and volatile global economic market environment tens of thousands of different instruments are traded on several dozen physical, electronic virtual exchange within the so-called U.S. alone, and several thousand mutual fund shares are offered from tens of thousands of investment management companies baiting, tempting and entrapping general depositors to utilize these variant forms of highly-complex, fragmented, antiquated, archaic, ancient history and superannuated physical, electronic, telephony, virtual, dumb terminal and/or webpage exchanges via propagating galactic proliferation of boisterous, pretentious, portentous and pretentious conceptual aids. Wherefrom terminological denominate syntactic synthesis invoking aforementioned UCMOST™ information technology is comprehensively suitable, generally pertinent and broadly useful to every and all, without limitation, aforementioned PUBLIC FINANCIALS instruments hereto harnessed, wrapped, leveraged and unequivocally apprehended in connection with every and all, without limitation, of the aforementioned PUBLIC FINANCIALS™ statements from every and all individual members of the aforementioned UNIVERSAL POPULACE™ which are heretofore and hereafter undeniably, logically, scientifically and intuitively comprehensively suitable, generally pertient and broadly useful to every and all real-time processing and/or reprocessing of data and/or information receiver entailing, encompassing, comprising, involving, impacting and/or effecting every and all asset, liability and residual equity ledger balance accounts of every and all private individuals inclusive, without limitation, of every and all public organizations within, throughout and transcending the national sovereign so-called borders of every and all of the industrialized, developed and developing free-market commerce and trade bloc economies within a single holistically econometric marketplace environment; wherefrom whichever further entailing, encompassing, comprising, involving, impacting and/or effecting every and all legal interstate and/or intrastrate Uniform Commercial Code (UCC), inclusive of legal transnational and/or transnational commercial mercantile free-trade agreements transcending national sovereign so-called borders of trade block mitigating every and all polarizing situations and/or unnecessary concerns involving: the Anti-Ballistic Misssle Treaty; the North American Free Trade Agreement (NAFTA); the European Economic Union (EEU); the Asian-Pacific Economic Community (APEC); wherefrom aforementioned PUBLIC FINANCIALS™ statements from every and all individual members of the aforementioned UNIVERSAL POPULACE™ which are heretofore and hereafter undeniably, logically, scientifically and intuitively comprehensively suitable, generally pertient and broadly useful to every and all real-time processing and/or reprocessing of data and/or information receiver entailing, encompassing, comprising, involving, impacting and/or effecting every and all ledger trace account, trial balance, cash flow, profit and loss and/or balance sheet; wherefrom whichever inherently, intrinsically, clearly, undeniably, logically, scientifically and ad intutively deriving and/or driving every and all personal financial statement inclusive of, without limitation, every and all public statement of revenue, cost of goods sold, depreciation expenditure, other operational expenditure, interest expenditure if applicable, taxes payable and/or deferred taxes payable, and residual profit if available, public statement of financial position or so-called public balance sheet, and public statement of cash flows inherently derived from every and all cash inflow and/or outflow from ledger account receivables, ledger account payables, acquisitions of property, plant, boiler and machinery equipment, ledger account short-term borrowing, ledger account long-term borrowing, new residual equity issuance and potential payment of dividends which occur, happen and/or transpire respectively from accounting, operating, exchanging, administrating, reconciling, managing and financing, inclusive of, without limitation, every and all distinctively separate and traditionally exclusive private and/or public off-balance sheet statement of financial position whichever owned as majority and/or minority participations, wherefrom fisher hereto every and all of which entail, encompass, comprise, involve, effect and impact every and all current and long-term ledger account asset receivable balances, ledger account asset Universal Character Set (UCS) and/or Universal Decimal System (UDS) driven and/or effectuated Universal Product Code (UPC) inventory balances, ledger account asset or potentially liability balances, ledger account other long-term asset balances, ledger account liability payable balances, ledger account structural capitalization residual equity balances, and other ledger account alternative structural capitalization residual equity balances, wherefrom further hereto every and all entail, encompass, comprise, involve, effect and impact every and all assets, liabilities and/or residual equities from private and/or public sub-unit, unit, divisional, segmented and/or consolidated elements, components, factors, constituents and ingredients comprising aforementioned PUBLIC FINANCIALS™ statements which inherently involve multifaceted and multidimensional non-financial account headings and non-financal contra-account headings entailing, encompassing, comprising, involving, impacting and/or effecting intrinsically and inherently, without limitation, every and all real-time processing and/or reprocessing of data and/or information receiver from every and all general populace, elected officials, appointed dignitaries, appointed diplomats, public/private organizations, sovereign government entities and/or not-for-profit organizations all of whom are respectively, independently, autonomously, evidently, undeniably, logically, scientifically and intuitively found to be inevitably necessary and increasingly integral member participants within a single holistically econometric marketplace environment. Wherefrom further invoking the innovative unequivocal absolute resolution solution within aforementioned UCMOST™ information technology, entials, encomapsses, comprises, involves, impacts and effects every and all, without limitation, of the vast numbers of spatiotemporal and geologistical: portable standalone and portable building fixture spatiotemporal manual and/or automatizing legal-trial court research reviewing instrument processing; fixtured standalone and building fixture spatiotemporal manual and/or automatizing legal-trial court research reviewing instrument processing; portable standalone and portable building fixture spatiotemporal manual and/or automatizing legal-trial court support advisory instrument processing; fixtured standalone and building fixture spatiotemporal manual and/or automatizing legal-trial court support advisory instrument processing; portable standalone and portable building fixture spatiotemporal manual and/or automatizing legal-trial court briefing writ habeas corpus filing instrument processing; fixtured standalone and building fixture spatiotemporal manual and/or automatizing legal-trial court briefing writ habeas corpus filing instrument processing; portable standalone and portable building fixture and/or automatizing legal-trial court subpeona pre-trial discovery instrument processing; portable standalone and portable building fixture spatiotemporal manual and/or automatizing legal-trial court subpeona pre-trial deposition instrument processing; fixtured standalone and building fixture spatiotemporal manual and/or automatizing legal-trial court subpeona pre-trial deposition instrument processing; portable standalone and portable building fixture spatiotemporal manual and/or automatizing legal-trial court object argument proceeding instrument processing; fixtured standalone and building fixture spatiotemporal manual and/or automatizing legal-trial court object argument proceeding instrument processing; portable standalone and portable building fixture spatiotemporal manual and/or automatizing legal-trial court summary adjudication instrument processing; fixtured standalone and building fixture spatiotemporal manual and/or automatizing legal-trial court summary adjudication instrument processing; portable standalone and portable building fixture spatiotemporal manual and/or automatizing legal-trial court jury peer findings and adjudication instrument processing; fixtured standalone and building fixture spatiotemporal manual and/or automatizing legal-trial court jury peer findings and adjudication instrument processing; portable standalone and portable building fixture spatiotemporal manual and/or automatizing legal-appellate court research reviewing instrument processing; fixtured standalone and building fixture spatiotemporal manual and/or automatizing legal-appellate court research reviewing instrument processing; portable standalone and portable building fixture spatiotemporal manual and/or automatizing legal-appellate court support advisory instrument processing; fixtured standalone and building fixture spatiotemporal manual and/or automatizing legal-appellate court support advisory instrument processing; portable standalone and portable building fixture spatiotemporal manual and/or automatizing legal-appellate court briefing writ habeas corpus filing instrument processing; fixtured standalone and building fixture spatiotemporal manual and/or automatizing legal-appellate court briefing writ habeas corpus filing instrument processing; portable standalone and portable building fixture spatiotemporal manual and/or automatizing legal-appellate court subpeona pre-trial discovery instrument processing; fixtured standalone and building fixture spatiotemporal manual and/or automatizing legal-appellate court subpeona pretrial deposition instrument processing; fixtured standalone and building fixture spatiotemporal manual and/or automatizing legal-appellate court subpeona pre-trial deposition instrument processing; portable standalone and portable building fixture spatiotemporal manual and/or automatizing legal-appellate court trial object argument proceeding instrument processing; fixtured standalone and building fixture spatiotemporal manual and/or automatizing legal-appellate court trial object argument proceeding instrument processing; portable standalone and portable building fixture spatiotemporal manual and/or automatizing legal-appellate court trial judge summary adjudication instrument processing; fixtured standalone and building fixture spatiotemporal manual and/or automatizing legal-appellate court trial judge summary adjudication instrument processing; portable standalone and portable building fixture spatiotemporal manual and/or automatizing legal-appellate court trial judge findings and adjudication instrument processing; fixtured standalone and building fixture spatiotemporal manual and/or automatizing legal-appellate court trial judge findings and adjudication instrument processing; portable standalone and portable building fixture spatiotemporal manual and/or automatizing legal-supreme court research reviewing instrument processing; fixtured standalone and building fixture spatiotemporal manual and/or automatizing legal-supreme court research reviewing instrument processing; portable standalone and portable building fixture spatiotemporal manual and/or automatizing legal-supreme court support advisory instrument processing; fixtured standalone and building fixture spatiotemporal manual and/or automatizing legal-supreme court support advisory instrument processing; portable standalone and portable building fixture spatiotemporal manual and/or automatizing legal-supreme court briefing writ habeas corpus filing instrument processing; fixtured standalone and building fixture spatiotemporal manual and/or automatizing legal-supreme court briefing writ habeas corpus filing instrument processing; portable standalone and portable building fixture spatiotemporal manual and/or automatizing legal-supreme court subpeona pre-trial discovery instrument processing; fixtured standalone and building fixture spatiotemporal manual and/or automatizing legal-supreme court subpeona pre-trial discovery instrument processing; fixtured standalone and building fixture spatiotemporal manual and/or automatizing legal-supreme court subpeona pre-trial deposition instrument processing; portable standalone and portable building fixture spatiotemporal manual and/or automatizing legal-supreme court trial object argument proceeding instrument processing; fixtured standalone and building fixture spatiotemporal manual and/or automatizing legal-supreme court trial object argument proceeding instrument processing; portable standalone and portable building fixture spatiotemporal manual and/or automatizing legal-supreme court trial judge summary adjudication instrument processing; fixtured standalone and building fixture spatiotemporal manual and/or automatizing legal-supreme court trial judge summary adjudication instrument processing; portable standalone and portable building fixture spatiotemporal manual and/or automatizing legal-supreme court trial judge findings and adjudication instrument processing; fixtured standalone and building fixture spatiotemporal manual and/or automatizing legal-supreme court trial judge findings and adjudication instrument processing; and moreover, wherefrom every and all, without limitation, of the vast numbers of spatiotemporal and geologistical: portable standalone and portable building fixture spatiotemporal manual and/or automatizing in-patient and/or out-patient medical admission, trasporting, release, tracking and multivendor billing and collection instrument processing; fixtured standalone and building fixture spatiotemporal manual and/or automatizing in-patient and/or out-patient medical admission, trasporting, release, tracking and multivendor billing and collection instrument processing; portable standalone and portable building fixture spatiotemporal manual and/or automatizing in-patient and/or out-patient life-support medicine instrument processing; fixtured standalone and building fixture spatiotemporal manual and/or automatizing in-patient and/or out-patient life-support medicine instrument processing; portable standalone and portable building fixture spatiotemporal in-patient and/or out-patient preventative medicine consult instrument processing; fixtured standalone and building fixture spatiotemporal manual and/or automatizing in-patient and/or out-patient preventative medicine consult instrument processing; portable standalone and portable building fixture spatiotemporal in-patient and/or out-patient emergency medicine trauma standalone and space less building fixture spatiotemporal in-patient and/or out-patient preventative elective medicine consult instrument processing; fixtured standalone and space less building fixture spatiotemporal in-patient and/or out-patient preventative elective medicine consult instrument processing; portable standalone and portable building fixture spatiotemporal in-patient and/or out-patient specialty medicine consult instrument processing, fixtured standalone and building fixture spatiotemporal in-patient and/or out-patient specialty medicine consult instrument processing; portable standalone and portable building fixture spatiotemporal in-patient and/or out-patient operational surgical medicine instrument processing; fixtured standalone and building fixture spatiotemporal in-patient and/or out-patient operational surgical medicine instrument processing, portable standalone and portable building fixture spatiotemporal in-patient and/or out-patient neurological surgical medicine instrument processing; fixtured standalone and building fixture spatiotemporal in-patient and/or out-patient neurological surgical medicine instrument processing; portable standalone and portable building fixture spatiotemporal in-patient and/or out-patient pathological medicine instrument processing; fixtured standalone and building fixture spatiotemporal in-patient and/or outpatient pathological medicine instrument processing; portable standalone and portable building fixture spatiotemporal in-patient and/or out-patient cardiological medicine instrument processing; fixtured standalone and building fixture spatiotemporal in-patient and/or out-patient cardiological medicine instrument processing; portable standalone and portable building fixture spatiotemporal in-patient and/or out-patient urological trace element medicine instrument processing; fixtured standalone and building fixture spatiotemporal in-patient and/or out-patient urological trace element medicine instrument processing; portable standalone and portable building fixture spatiotemporal in-patient and/or out-patient radiological plate and film xerographic medicine instrument processing; fixtured standalone and building fixture spatiotemporal in-patient and/or outpatient radiological plate and film xerographic medicine instrument processing; portable standalone and portable building fixture spatiotemporal in-patient and/or out-patient chemoradiology medicine instrument processing; fixtured standalone and building fixture spatiotemporal in-patient and/or out-patient chemoradiology medicine instrument building fixture spatiotemporal in-patient and/or out-patient physiological medicine instrument processing; portable standalone and portable building fixture spatiotemporal in-patient and/or out-patient biological medicine instrument processing; fixtured standalone and building fixture spatiotemporal in-patient and/or out-patient biological medicine instrument processing; portable standalone and portable building fixture spatiotemporal in-patient and/or out-patient genetic medicine instrument processing; fixtured standalone and building fixture spatiotemporal in-patient and/or out-patient genetic medicine instrument processing; portable standalone and portable building fixture spatiotemporal in-patient and/or out-patient fertility medicine instrument processing; fixtured standalone and building fixture spatiotemporal in-patient and/or outpatient fertility medicine instrument processing; portable standalone and portable building fixture spatiotemporal in-patient and/or out-patient psychological preventative medicine instrument processing; fixtured standalone and building fixture spatiotemporal in-patient and/or out-patient psychological preventative medicine instrument processing; portable standalone and portable building fixture spatiotemporal in-patient and/or outpatient psychological rehabilitative medicine instrument processing; fixtured standalone and building fixture spatiotemporal in-patient and/or out-patient psychological rehabilitative medicine instrument processing; portable standalone and portable building fixture spatiotemporal in-patient and/or out-patient surgical recovery medicine instrument processing, fixtured standalone and building fixture spatiotemporal in-patient and/or outpatient surgical recovery medicine instrument processing; portable standalone and portable building fixture spatiotemporal in-patient and/or out-patient physical rehabilitation medicine instrument processing; fixtured standalone and building fixture spatiotemporal in-patient and/or out-patient physical rehabilitation recovery medicine instrument processing; portable standalone and portable building fixture spatiotemporal home health care medicine instrument processing; fixtured standalone and building fixture spatiotemporal home health care medicine instrument processing; portable standalone and portable building fixture spatiotemporal hospice care medicine instrument processing; fixtured standalone and building fixture spatiotemporal hospice care medicine instrument processing; portable standalone and portable building fixture standalone and building fixture spatiotemporal prescription drug ordering, filling, distribution and reodering, refilling, transport redistribution inclusive of billing and collection instrument processing; portable standalone and portable building fixture spatiotemporal major medical orthopedic surgical instrument processing; fixtured standalone and building fixture spatiotemporal major medical orthopedic surgical instrument processing; portable standalone and portable building fixture spatiotemporal major medical orthoscopic surgical instrument processing; fixtured standalone and building fixture spatiotemporal major medical orthoscopic surgical instrument processing; portable standalone and portable building fixture spatiotemporal major medical dental surgical instrument processing; fixtured standalone and building fixture spatiotemporal major medical dental surgical instrument processing; portable standalone and portable building fixture spatiotemporal major medical vision surgical instrument processing; fixtured standalone and building fixture spatiotemporal major medical vision surgical instrument processing; portable standalone and portable building fixture spatiotemporal proprietary and/or group office preventative medical consult multiport invoice billing and collection instrument processing; fixtured standalone and building fixture spatiotemporal proprietary and/or group office preventative medical consult multiport invoice billing and collection instrument processing; and wherefrom further every and all, without limitation, of the vast numbers of spatiotemporal and geologistical: portable standalone and portable building fixture spatiotemporal personal and/or commercial insurance auditory and spontaneous real-estate inspection tangible property assessment and verification instrument processing; fixtured standalone and building fixture spatiotemporal personal and/or commercial insurance auditory and spontaneous real-estate inspection tangible property assessment and verification instrument processing; inclusive of every and all, without limitation, income, capital gains, taxes, charitable contribution, endowment, foundation, inheritance, transactional, estate and/or social security entitlement automated teller machine and/or so-called electronic deposit, withdrawing, transporting, letter of crediting, equity lines, credit lines, revolving credit lines, credit cards, debit cards, prepaid debit cards, check draft cards, certified check drafting, traveling check drafting, merchant, commercial, retail and/or mortgage banking, and/or services services wherefrom every and all are heretofore antiquated, archaic, ancient history and superannuated methodologies and processing techniques proliferating so-called telecommunications among depositors in locale and transcontinental fashion in an effort at further propagating boisterous, bolstering, voracious, raptorial, pretentious, portentous and pretentious proliferation of the utilization of antiquated, archaic, ancient history and superannuated methods and processes herewith evinced as specious, fruitless and hereto notwithstanding wherefrom it is clearly an undeniable and evidentiary findings of fact, documented reference, logical scientific deduction and intuitive analytical reasoning that within the heretofore highly dynamic and volatile global economic market environment tens of thousands of different instruments are traded on several dozen physical, electronic virtual exchange within the so-called U.S. alone, and several thousand mutual fund shares are offered from tens of thousands of investment management companies baiting, tempting and entrapping general depositors to utilize these variant forms of highly-complex, fragmented, antiquated, archaic, ancient history and superannuated physical, electronic, telephony, virtual, dumb terminal and/or webpage exchanges via propagating galactic proliferation of boisterous, pretentious, portentous and pretentious conceptual aids, whereof hereto aforementioned UCMOST™, a invention applied for patent:

1. UCMOST™ Information Technology—General Overview

The novel, unobvious, unique, unknown, unforeseen, unprecedented, ease of use and panacean cutting-edge technological innovations invoked within aforementioned UCMOST™ information technology is moreover comprehensively suitable, generally pertinent and broadly useful utility and design formulation existent due exclusively to every and all original abstract conceptual thought processes and know-how inclusive of every and all authentically initiated and undertaken copious works of art and authorship of a single proprietor and independent inventor which ensures the members of the aforementioned UNIVERSAL POPULACE™ is offered the utility engineering and architectural design of useful products and services which in every and all techniques, methods and combinations innately and intrinsically concretizes innovative groundbreaking and combinatorial breakthrough utility engineering and architectural design propagations entailing, encompassing, comprising, involving, impacting and/or effecting every and all basic functional elements, necessary interactions and integral transactional exchange initiatives, schemes, ocurrences, happenings, interactions, processes, methods, practices, movements, proceedings, messaging, presentations, notifications, filings, submissions, records, activities, actions, events, endeavors, tasks and affairs of an aforementioned efficient UNIVERSAL CAPITAL MARKET™ to offer members of the aforementioned UNIVERSAL POPULACE™ full disclosure, best practices, best executions, enhanced fairness, simulteanoues equality, full transparency, consolidated access and perpetual integration to integrated closed circuitry automatizing real-time holistically steady state synchronized ubiquitous continuum real-time rhombus microprocessing instantaneous transmission and receiver transforming traverse conduit aforementioned UCMOST™ real-time processing and/or reprocessing of every and all aforementioned PUBLIC FINANCIALS™ statements inclusive of seamlessly and naturally wrapped, twisted, mixed, convoluted, embroidered and combined in connection with aforementioned PUBLIC FINANCIALS™ instruments comprehensively suitable, generally pertinent and broadly useful every and all public accounting, transport reconciling, independent auditing and financial reporting to concretize full disclosure, best practices, best executions, enhanced fairness, simulteanoues equality, full transparency, consolidated access and perpetual integration from members of the aforementioned UNIVERSAL POPULACE™ whichever every and all are furthermore undeniably, logically, scientifically and intuitively deduced, apprehended and invoked as necessarily integrated, critically important and increasingly integral members of the aforementioned UNIVERSAL POPULACE™ via integrated closed circuitry automatizing real-time holistically steady state synchronized ubiquitous continuum real-time rhombus microprocessing instantaneous transmission and receiver transforming traverse conduit aforementioned UCMOST™ real-time processing and/or reprocessing are comprehensively suitable, generally pertinent and broadly useful every and all quotation, clearance, execution, settlement, and exchange aforementioned PUBLIC suitable, generally pertinent and broadly useful insurance, risk financing, credit, cash management, transactional exchange banking, and aforementioned PUBLIC FINANCIALS™ instruments entailing, encompassing, comprising, involving, impacting and/or effecting every and all techniques, designs, systems, routines, devices, manners, modes, fashions, forms, formats, factors, objects, parts, segments, elements, components, constituents, ingredients, processes, methods and combinations on behalf of every and all of the tens of hundreds of thousands members of the aforementioned UNIVERSAL POPULACE™ and hundreds of millions members of the aforementioned UNIVERSAL POPULACE™ to preemptively circumvent exponential tempestuous devaluations aforementioned PUBLIC FINANCIALS™ instruments by mitigating tempestuous exponentially detrimental increases in systematic volatility and tempestuous exponentially debilitating increases in the cost of capital within an aforementioned efficient UNIVERSAL CAPITAL MARKET™ of the global marketplace. The novel, unobvious, unique, unknown, unforeseen, unprecedented, ease of use and panacean cutting-edge technological innovation invoked within aforementioned UCMOST™ information technology is furthermore comprehensively suitable, generally pertinent and broadly useful utility and design formulation of existent techniques, designs, systems, devices, processes, parts, segments, methods, combinations, know-how, ideas, art forms, articles of manufacture, discoveries, formulae of invitatory streamlined rhombus microprocessing utility engineering and architectural design composition which offers groundbreaking and breakthrough utility engineering and architectural design propagations of products and services to concretize use, manufacture, testing, production, development, distribution, and implementation as novel, unobvious, unknown, unforeseen, unprecedented products and services in every and all ancient history, present and prospectively deployed computing devices and systems throughout the world, to completely resolve every and all tremendously long-held and enormously heart-felt unmet needs in the relevant art entailing, encompassing, comprising, involving, effecting and impacting every and all of the distinctively separate and traditionally exclusive specialty areas of holistically steady state continuous spectrum ubiquitous indistinguishably synchronous needs involving aforementioned UCMOST™ real-time exchange initiatives, schemes, ocurrences, happenings, interactions, processes, methods, practices, movements, proceedings, messaging, presentations, notifications, filings, submissions, records, activities, actions, events, endeavors, tasks and affairs which evidently are legally, undeniably, logically, scientifically and intuitively entail, encompass, comprise, involve, effect and impact the treasure accounting, financial fueling and econometric energizing members of the aforementioned UNIVERSAL POPULACE™ which heretofore is continuously subject to harming, damaging, inuring, insistent, insinuating, imposing, pestilent, impetuous, importune, pestiferous, condescending and insolent enthralling, hindering, entrapping, pretending, miring, fatiguing, maleficience, harassing, engulfing, pressing, malevolent, presuming, imprinting, malicious, suffocating, miring, strangling, repressing, entangling, pestering and oppressing within an aforementioned fragmenting capital market inefficiencies which lacks every and all techniques, designs, systems, routines, devices, manners, modes, fashions, forms, formats, factors, objects, parts, segments, elements, components, constituents, ingredients, processes, methods and combinations of panacean cutting-edge and innovative information technology entailing, encompassing, comprising, involving, impacting and/or effecting every and all basic functional elements, necessary interactions and integral transactional exchange initiatives, schemes, ocurrences, happenings, interactions, processes, methods, practices, movements, proceedings, messaging, presentations, notifications, filings, submissions, records, activities, actions, events, endeavors, tasks and affairs found prevalent within an aforementioned efficient UNIVERSAL CAPITAL MARKET™ which historically and present are subjected to undue, undeniable, unnecessary, unwarranted, illogical, unjustifiable, unreasoned and unmitigated and unjustified tempestuous exponentially detrimental increases in systematic volatility and undue, undeniable, unnecessary, unwarranted, illogical, unjustifiable, unreasoned and unmitigated and unjustified tempestuous exponentially debilitating increases in the cost of capital with aforementioned fragmenting capital market inefficiencies. The novel, unobvious, unique, unknown, unforeseen, unprecedented, ease of use and panacean cutting-edge technological innovations invoked within aforementioned UCMOST™ information technology is moreover segments, methods, combinations, know-how, ideas, art forms, articles of manufacture, discoveries, formulae, and streamlined architectural engineering procedural computing processing design compositions which offer members of the aforementioned UNIVERSAL POPULACE™ an innovative groundbreaking and breakthrough utility engineering and architectural design propagations universal microprocessor computing design provision which can be used, manufacture, tested, produced, developed, distributed, and implemented as strikingly novel, unobvious, unknown, unforeseen, unprecedented and panacean cutting-edge products and services in every and all present deployed and prospectively hereafter developed, deployed and implemented in every and all computing devices and systems anywhere, anytime and anyplace in the world, to concretize a highly efficient and effective technological development and advancement to offer members of the aforementioned UNIVERSAL POPULACE™ from around the world low-cost economic benefits and high-end personal efficiencies in every and all basic functional elements, necessary interactions and integral transactional exchange initiatives, schemes, ocurrences, happenings, interactions, processes, methods, practices, movements, proceedings, messaging, presentations, notifications, filings, submissions, records, activities, actions, events, endeavors, tasks and affairs found prevalent within an aforementioned efficient UNIVERSAL CAPITAL MARKET™. The novel, unobvious, unique, unknown, unforeseen, unprecedented, ease of use and panacean cutting-edge technological innovation invoked within aforementioned UCMOST™ information technology is furthermore comprehensively suitable, generally pertinent and broadly useful utility and design formulation herewith existent techniques, designs, systems, devices, processes, parts, segments, methods, combinations, know-how, ideas, art forms, articles of manufacture, discoveries, formulae, and streamlined architectural engineering procedural computing processing design compositions which offer members of the aforementioned UNIVERSAL POPULACE™ an innovative groundbreaking and breakthrough utility engineering and architectural design propagating universal microprocessor computing design innovative development and technological advancement which is used, manufacture, tested, produced, developed, distributed, and implemented as to concretize novel, unobvious, unknown, unforeseen, unprecedented and artificial computing devices and articles available within a single holistically econometric marketplace environment to offer members of the aforementioned UNIVERSAL POPULACE™ a natually seamless, functionally integrated and innovative combinatorial bridge oriented digital platform which is technologically capable of realizing integrated closed circuitry automatizing real-time holistically steady state synchronized ubiquitous continuum real-time rhombus microprocessing instantaneous transmission and receiver transforming traverse conduit aforementioned UCMOST™ real-time processing and/or reprocessing of every and all aforementioned PUBLIC FINANCIALS™ statements in connection with every and all aforementioned PUBLIC FINANCIALS™ instruments inclusive of every and all aforementioned PUBLIC FINANCIALS™ instruments transactional exchange real-time data retrieval in connection with every and all aforementioned PUBLIC FINANCIALS™ instruments transactional exchange real-time information retrieval to concretize the necessary exchange of tens of hundreds of billions of transactions and/or interactions entailing, encompassing, comprising, involving, impacting and/or effecting the transmission and receipt of global every and all real-time processing and/or reprocessing of data and/or information receiver among tens of hundreds of thousands members of the aforementioned UNIVERSAL POPULACE™, and hundreds of millions members of the aforementioned UNIVERSAL POPULACE™ inclusive of, without limitation, everyone, everybody, everyhow, everyway, everything, everytime, everyplace, everywhere around the world. The novel, unobvious, unique, unknown, unforeseen, unprecedented, ease of use and panacean cutting-edge technological innovation invoked within aforementioned UCMOST™ information technology is furthermore comprehensively suitable, generally pertinent and broadly useful utility and design formulation herewith existent for every and all use, manufacture, testing, producing, developing, distributing, deploying and implementing in every and all computing devices and systems in the world inclusive of, without limitation, every and all innovative derivative commercialized information technology implementations of every and all techniques, designs, systems, routines, devices, manners, modes, fashions, forms, formats, factors, objects, parts, segments, elements, components, constituents, ingredients, processes, methods and combinations entailing, encompassing, comprising, developed, distributed, deployed and implemeted. Whereas, it is an undeniable and evidentiary findings of fact, documented reference, logical scientific deduction and intuitive analytical reasoning that the panacean cutting-edge technological innovation invoked within aforementioned UCMOST™ information technology is furthermore comprehensively suitable, generally pertinent and broadly useful as an innovative formulary wherefrom hereto existent innovative developments and technological advancements traversed via transduction transform converter of physical power utility mechanical to electrical fuel energy catalysts whether every and all standalone and/or combinatorial forms of traditional fuel energy are concretizing via steam, coal, dam, gasoline, diesel, mixed gasoline and oil, or propagating traverse via every and all traditonal mechanical friction and/or chemical reaction to electrical and/or rocket fuel energy via conduit electrical generation and/or electrical battery, wherefrom hereto via every and all advanced electronic locational systematizing geological and/or seismological processes concretizing innovative wheresoever transcendent EPROM, degauss and/or magnetostriction preemptively constrained ferromagnetic alloy, silicon, germanium, biodynamic and/or geomagnetic resonant soundproof and fireclay wall protective fireball impervious microcircuit epoxy casting insulated permeability of artificial semi-conducting microcircuit devices, articles, apparatuses, refractories and/or megastructures internalizing upright orthorhombic tentacular boundless steady state roving antennule transmuting metric conversional transistor transfusing receiver concretizing high-quality holistically steady state heliocentrically synchronizing ubiquitous hunting continuum parallel redundancy cosmos robotizing digitalized galactic transmitting receiver of spatiotemporal emitted broadcasting of real-time microprocessing traversing a single independent portal refractory evincing minutia partible iota beta particle trace element wave front continuous spectrum pulse signaling transmission conveying efficient energizing and fueling powered catalytic conduits via electrogasdynamics, electrogenesis, electrohydraulic, geomagnetic, gyromagnetic, geokinetic and/or thermodynamic rheostat regulated staple galactic iota minutia fueled and powered apparatuses, articles and/or megastructures inclusive of, without limitation, every and all of the following: members of the aforementioned UNIVERSAL atmospheric wireline and wireless telephone devices, methods, processes and articles; wireline and wireless telephone devices, methods, processes and articles; pay-on-demand public telephones; pre-paid card-on-demand telephone services; pay-on-demand wireless telephones; pre-paid subscription wireless telephones; pay-on-demand public wireless laptops and/or tablets; pre-paid public wireless laptops and/or tablets; pay-on-demand public devices; pre-paid subscription public devices; pay-on-demand public telephone booths; free-service public access way call boxes; pay-on-demand astronomical telescopes; pre-paid subscription astronomical telesocpes; pay-on-demand microcosmic electron microscopes; pre-paid subscription microsmic electron microscopes; pay-on-demand radio dishes; pre-paid subscription radio dishes; pay-on-demand public electronic pagers; pre-paid subscription electronic pagers; portable and/or fixtured automated teller machine devices, methods, processes and articles; portable and fixtured so-called gaming machine devices, methods, processes and articles; physical and virtual shopping cart devices, methods, processes and articles; physical and virtual so-called currency archaic tape register devices, methods, processes and articles; physical and virutal so-called arithmetic and advanced level calculating devices, methods, processes and articles; portable digital assistant devices, methods, processes and articles; portable walk-man devices, methods, processes and articles; telegraphy devices, methods, processes and articles; telemetry devices, methods, processes and articles; teletext devices, methods, processes and articles; teletype devices, methods, processes and articles; portable form factor computing tablets; desktop microcomputing apparatuses; laptop microcomputing apparatuses; portable fixtured computing devices, methods, processes and articles; portable geological timepiece devices, methods, processes and articles; portable communicative image televise viewing devices: appended fixture commuicative image viewing devices, methods, processes and articles; small, medium and large upright cross-sectional orthorhombic rhombus bi-directional transom, cross and/or gallow atmospheric fixtured billboards; small, medium and large upright cross-sectional orthorhombic rhombus bi-directional transom, cross and/or gallow atmospheric fixtured posterboards; small, medium and large upright cross-sectional orthorhombic rhombus bi-directional transom, cross and/or gallow atmospheric fixtured and/or fixtured window-pane boards; small, medium and large upright cross-sectional orthorhombic rhombus bi-directional transom, cross and/or gallow atmospheric portable and/or fixtured wall-pane boards; wherefrom further hereto it is clearly an undeniable and evidentiary findings of fact, documented reference, logical scientific deduction and intuitive analytical reasoning that the panacean cutting-edge technological innovation invoked within aforementioned UCMOST™ information technology is furthermore comprehensively suitable, generally pertinent and broadly useful as an innovative formulary wherefrom hereto existent innovative developments and technological advancements comprehensively suitable, generally pertinent and broadly useful within every and all air, d, water and/or space atmospheric orbital propagations traversed via transduction transform converter of physical power utility mechanical to electrical fuel energy catalysts whether every and all standalone and/or combinatorial forms of traditional fuel energy are concretizing via steam, coal, dam, gasoline, diesel, mixed gasoline and oil, or propagating traverse via every and all traditonal mechanical friction and/or chemical reaction to electrical and/or rocket fuel energy via conduit electrical generation and/or electrical battery, wherefrom hereto via every and all advanced electronic locational systematizing geological and/or seismological processes concretizing innovative wheresoever transcendent EPROM, degauss and/or magnetostriction preemptively constrained ferromagnetic alloy, silicon, germanium, biodynamic and/or geomagnetic resonant soundproof and fireclay wall protective fireball impervious microcircuit epoxy casting insulated permeability of artificial semi-conducting microcircuit devices, articles, apparatuses, refractories and/or megastructures internalizing upright orthorhombic tentacular boundless steady state roving antennule transmuting metric conversional transistor transfusing receiver concretizing high-quality holistically steady state heliocentrically synchronizing ubiquitous hunting continuum parallel redundancy cosmos robotizing digitalized galactic transmitting receiver of spatiotemporal emitted broadcasting of real-time microprocessing traversing a single independent portal refractory evincing minutia partible iota beta particle trace element wave front continuous spectrum pulse signaling transmission conveying efficient energizing and fueling powered catalytic conduits via electrogasdynamics, electrogenesis, megastructures inclusive of, without limitation, every and all of the following: atmospheric every and all aboveground aboveground spacecraft, space capsule, space shuttle, space station and/or spaceport launching and shuttle transport airspace, airwaves, ground waves, highway, subway, parkway, passage, toll booth, tunnel, conduit, channel, pipe, aqueduct, road, roadway, railroad and/or rail-line traverse access way work productivity, living, resting, entertainment, recreational, health, fitness, safety and nutritional traverse concretizing articles and access ways inclusive of waiting rooms, travel planning arrangement stations, holding constructs, docking facilities and parking complexes; wherefrom hereto moreover every and all atmospheric aboveground spacecraft, space capsule, space shuttle, space station and/or spaceport and shuttle transport airspace, airwaves, ground waves, highway, subway, parkway, passage, toll booth, tunnel, conduit, channel, pipe, aqueduct, road, roadway, railroad and/or rail-line traverse access way vehicle licensing, emission inspection, identification registration, portable traverse access way work productivity, living, resting, entertainment, recreational, health, fitness, safety and nutritional traverse concretizing portable launch pad access ways inclusive of waiting rooms, travel planning arrangement stations, parking constructs, fueling facilities and docking complexes; wherefrom hereto furthermore every and all atmospheric, aboveground, underground, underwater, submersible, aerospace aeronautical galactic and/or aerospace aeronautical intergalactic spatiotemporal fire protection, health maintenance, police correctional, water and sewer, utility fuel and energy power, labor employment and work productivity, communications and technologies, emergency calling and emergency planning, access way transport craft airspace, airwaves, ground waves, highway, subway, parkway, passage, toll booth, tunnel, conduit, channel, pipe, aqueduct, road, roadway, railroad and/or rail-line traverse concretizing articles and access ways inclusive of waiting rooms, travel planning arrangement stations, holding constructs, docking facilities and parking complexes; wherefrom hereto morevoer every and all atmospheric, aboveground, underground, underwater, submersible, aerospace aeronautical galactic and/or aerospace aeronautical intergalactic spatiotemporal vehicle transit bi-directional directive and/or preventive rhombus stabilized transom upright post, cross and/or gallows on-track and/or off-track highway, subway, parkway, passage, toll booth, tunnel, conduit, channel, pipe, aqueduct, road, roadway, railroad and/or rail-line traverse concretizing articles and access ways inclusive of waiting rooms, travel planning arrangement stations, holding constructs, docking facilities and parking complexes; wherefrom hereto furthermore every and all atmospheric, aboveground, underground, underwater, submersible, aerospace aeronautical galactic and/or aerospace aeronautical intergalactic spatiotemporal vehicle transit bi-directional directive and/or preventive rhombus stabilized transom upright post, cross and/or gallows on-track and/or off-track access way transport craft detoured, hazardous construct and/or haphazard locational signaling transport airspace, airwaves, ground waves, highway, subway, parkway, passage, toll booth, tunnel, conduit, channel, pipe, aqueduct, road, roadway, railroad and/or rail-line traverse concretizing articles and access ways inclusive of waiting rooms, travel planning arrangement stations, holding constructs, docking facilities and parking complexes; wherefrom hereto moreoever every and all atmospheric, aboveground, underground, underwater, submersible, aerospace aeronautical galactic and/or aerospace aeronautical intergalactic spatiotemporal vehicle transit bi-directional directive and/or preventive rhombus stabilized transom upright post, cross and/or gallows on-track and/or off-track access way transport craft small, medium and/or large sized display sign, poster board and/or billboard locational signaling transport airspace, airwaves, ground waves, highway, subway, parkway, passage, toll booth, tunnel, conduit, channel, pipe, aqueduct, road, roadway, railroad and/or rail-line traverse concretizing articles and access ways inclusive of waiting rooms, travel planning arrangement stations, holding constructs, docking facilities and parking complexes; wherefrom hereto furthermore every and all atmospheric, aboveground, underground, underwater, submersible, aerospace aeronautical galactic and/or aerospace aeronautical intergalactic spatiotemporal vehicle transit bi-directional directive and/or preventive rhombus stabilized transom upright post, cross and/or gallows on-track and/or off-track access way transport craft driving-meter axle movement, thoroughfare-meter axle traverse and/or parking-meter axle stand locational signaling transport airspace, airwaves, ground waves, highway, subway, parkway, passage, toll booth, tunnel, conduit, channel, pipe, aqueduct, road, roadway, railroad and/or rail-line traverse concretizing articles and and all atmospheric, aboveground, underground, underwater, submersible, aerospace aeronautical galactic and/or aerospace aeronautical intergalactic spatiotemporal vehicle transit bi-directional directive and/or preventive rhombus stabilized transom upright post, cross and/or gallows off-track surface paint, curbside, sidewall, median paint, median curbside and median sidewall access way transport craft boundary locational signaling airspace, airwaves, ground waves, highway, subway, parkway, passage, toll booth, tunnel, conduit, channel, pipe, aqueduct, road, roadway, railroad and/or rail-line traverse concretizing articles and access ways inclusive of waiting rooms, travel planning arrangement stations, holding constructs, docking facilities and parking complexes; wherefrom hereto furthermore every and all atmospheric, aboveground, underground, underwater, submersible, aerospace aeronautical galactic and/or aerospace aeronautical intergalactic spatiotemporal article fueling power licensing and article refueling power relicensing, article emission inspection and article emission reinspection, article registration and article reregistration, article insurance and article reinsurance inclusive of every and all article assurance and article reassurance along with necessary upkeep article upkeep locations every and all incorporating waiting rooms with small, medium and large open-space resting areas within a confined space allotments to serve access way transport craft boundary locational signaling airspace, airwaves, ground waves, highway, subway, parkway, passage, toll booth, tunnel, conduit, channel, pipe, aqueduct, road, roadway, railroad and/or rail-line traverse concretizing articles and access ways inclusive of waiting rooms, travel planning arrangement stations, holding constructs, docking facilities and parking complexes; wherefrom hereto moreover every and all atmospheric aboveground and/or abovewater domed, uncovered and/or retractable roofed recreational and entertainment theatrical, sport and play parks, civic centers, atriums, stadiums and arenas waiting rooms with small, medium and large open-space resting areas within a confined space allotments, with walkways and patios inclusive of health food and poultry cafeterias and nutritional restaurants incorporating merchandising products, goods, supplies and services galleries within merchandising products, goods, supplies and services warehouses with necessary resting areas and hygiene quarters every and all facilitated via elevator and/or escalator apparatus access way transport craft airspace, articles and access ways inclusive of waiting rooms, travel planning arrangement stations, holding constructs, docking facilities and parking complexes; wherefrom hereto furthermore every and all atmospheric, aboveground, underground, underwater, submersible, aerospace aeronautical galactic and/or aerospace aeronautical intergalactic spatiotemporal merchandising products, goods, supplies and services shopping malls, waiting rooms with small, medium and large open-space resting areas within a confined space allotments, walkways and patios inclusive of health food and poultry cafeterias and nutritional restaurants incorporating every and all merchandising products, goods, supplies and services galleries within merchandising products, goods, supplies and services warehouses with necessary resting areas and hygiene quarters every and all facilitated via elevator and/or escalator apparatus access way transport craft airspace, airwaves, ground waves, highway, subway, parkway, passage, toll booth, tunnel, conduit, channel, pipe, aqueduct, road, roadway, railroad and/or rail-line traverse concretizing articles and access ways inclusive of waiting rooms, travel planning arrangement stations, holding constructs, docking facilities and parking complexes; wherefrom hereto moreover every and all atmospheric abovewater watercraft small-sized economy, mid-sized economy, mid-class and high-society luxury entertainment and recreational sightseeing, cruising, playing and sportfishing transport vessel access way transport craft airspace, airwaves, ground waves, highway, subway, parkway, passage, toll booth, tunnel, conduit, channel, pipe, aqueduct, road, roadway, railroad and/or rail-line traverse concretizing articles and access ways inclusive of waiting rooms, travel planning arrangement stations, holding constructs, docking facilities and parking complexes; wherefrom hereto furthermore every and all atmospheric watercraft atmospheric watercraft super-sized and high-society luxury mega-yacht entertainment and recreational sightseeing, cruising, playing and sportfishing transport vessel access way transport craft airspace, airwaves, ground waves, highway, subway, parkway, passage, toll booth, tunnel, conduit, channel, pipe, aqueduct, road, roadway, railroad and/or rail-line traverse concretizing articles and access ways inclusive of waiting rooms, travel planning arrangement stations, holding constructs, docking facilities and parking complexes; wherefrom hereto moreover every and all atmospheric abovewater economy, mid-class following: waiting rooms with small, medium and large open-space resting areas within a confined space allotment, lobby rooms with small, medium and large meeting rooms including conference galleries incorporating necessary members of the aforementioned UNIVERSAL POPULACE™ work productivity rooms with necessary refreshment and snack vending locations inclusive of hygiene quarters and potential facilitating integral health and fitness facilities along with health prevention safety quarters while ensuring health food and poultry cafeterias and nutritional restaurants along with fast-food restaurants ensuring merchandising galleries for distribution of products, goods, services and supplies with built-in recreational and entertainment night clubs and cinema complexes every and all facilitated via elevator and/or escalator apparatus access way transport craft airspace, airwaves, ground waves, highway, subway, parkway, passage, toll booth, tunnel, conduit, channel, pipe, aqueduct, road, roadway, railroad and/or rail-line traverse concretizing articles and access ways inclusive of waiting rooms, travel planning arrangement stations, holding constructs, docking facilities and parking complexes; wherefrom hereto furthermore every and all electrogasdynamics, electrogenesis, electrohydraulic, geomagnetic, gyromagnetic, geokinetic and/or thermodynamic rheostat regulated staple galactic iota minutia fueled and powered apparatus article atmospheric, aboveground, underground, underwater, submersible, astronautical galactic and/or astronautical intergalactic engaging articles, apparatuses and megastructure biospheric and/or atmos tropospheric, atmos tropopause, atmos stratospheric, atmos mesospheric, atmos thermospheric access way transport craft and/or orbital positioning breakthrough atmos vanallen belt to/from outerspace spacecraft, space capsule, space shuttle, space station and/or spaceport economy, mid-class and high-society hotel bed and resort building entrances inclusive of, without limitation every and all of the following: waiting rooms with small, medium and large open-space resting areas within a confined space allotment, lobby rooms with small, medium and large meeting rooms and conference galleries incorporating necessary hereto members of the aforementioned UNIVERSAL POPULACE™ work productivity rooms with necessary resting rooms and hygiene quarters facilitating integral health and fitness facilities and health prevention safety quarters while ensuring health food and poultry cafeterias and entertainment night clubs and cinema complexes every and all facilitated via elevator and/or escalator apparatus access way transport craft airspace, airwaves, ground waves, highway, subway, parkway, passage, toll booth, tunnel, conduit, channel, pipe, aqueduct, road, roadway, railroad and/or rail-line traverse concretizing articles and access ways inclusive of waiting rooms, travel planning arrangement stations, holding constructs, docking facilities and parking complexes; wherefrom hereto moreover every and all atmospheric, aboveground, underground, underwater, submersible, aerospace aeronautical galactic and/or aerospace aeronautical intergalactic spatiotemporal access way rugged, rough, economy, sport and/or luxury transport craft one-wheel, two-wheel, three-wheel, four-wheel, five-wheel, six-wheel, seven-wheel, eight-wheel, nine-wheel, ten-wheel, eleven-wheel, twelve-wheel, thirteen-wheel, fourteen-wheel, fifteen-wheel, sixteen-wheel, seventeen-wheel, eighteen-wheel and moreover every and all increasing wheel-based numbered devices, methods, processes and articles inclusive of one-engine, two-engine, three-engine, four-engine, five-engine, six-engine, seven-engine, eight-engine, nine-engine, ten-engine, twelve-engine, eleven-engine, twelve-engine, thirteen-engine, fourteen-engine, fifteen-engine, sixteen-engine, seventeen-engine, eighteen-engine and furthermore every and all increasing engine-based numbered devices, methods, processes and articles inclusive of one-rocket, two-rocket, three-rocket, four-rocket, five-rocket, six-rocket, seven-rocket, eight-rocket, nine-rocket, ten-rocket, twelve-rocket, eleven-rocket, twelve-rocket, thirteen-rocket, fourteen-rocket, fifteen-rocket, sixteen-rocket, seventeen-rocket, eighteen-rocket inclusive of every and all increasing rocket-based numbered devices, methods, processes and articles concretizing every and all axial driven, steered, directed, targeted, maneuvered and/or controlled motored, powered, thrust and/or propelled devices, methods, processes and articles transported via airspace, airwaves, ground waves, highway, subway, parkway, passage, toll booth, tunnel, conduit, channel, pipe, aqueduct, road, roadway, railroad and/or rail-line traverse access way space, bed, surface, pavement, traverse and/or propagating on and/or off traverse access way space inclusive of, without limitation, every and all ramjet, supersonic jet, speed jet, executive jet, pleasure jet, jetliner, airliner, helicopter, snowski, cycle, car, auto, van, trailer, truck, limosine, bus, rail-line and train transport airspace, wherefrom hereto furthermore every and all atmospheric, aboveground, underground, underwater, submersible, aerospace aeronautical galactic and/or aerospace aeronautical intergalactic spatiotemporal access way rugged, rough, economy, sport and/or luxury transport craft one-wheel, two-wheel three-wheel, four-wheel, five-wheel, six-wheel, seven-wheel, eight-wheel, nine-wheel, ten-wheel, eleven-wheel, twelve-wheel, thirteen-wheel, fourteen-wheel, fifteen-wheel, sixteen-wheel, seventeen-wheel, eighteen-wheel and every and all increasing wheel-based numbered devices, methods, processes and articles; wherefrom moreover inclusive of one-engine, two-engine, three-engine, four-engine, five-engine, six-engine, seven-engine, eight-engine, nine-engine, ten-engine, twelve-engine, eleven-engine, twelve-engine, thirteen-engine, fourteen-engine, fifteen-engine, sixteen-engine, seventeen-engine, eighteen-engine and furthermore every and all increasing engine-based numbered devices, methods, processes and articles; wherefrom further inclusive of one-rocket, two-rocket, three-rocket, four-rocket, five-rocket, six-rocket, seven-rocket, eight-rocket, nine-rocket, ten-rocket, twelve-rocket, eleven-rocket, twelve-rocket, thirteen-rocket, fourteen-rocket, fifteen-rocket, sixteen-rocket, seventeen-rocket, eighteen-rocket inclusive of every and all increasing rocket-based number including ramjet supersonic rocket engine devices, methods, processes and articles concretizing concretizing every and all axial driven, steered, directed, targeted, maneuvered and/or controlled motored, powered, thrust and/or propelled devices, methods, processes and articles transported via airspace, airwaves, ground waves, highway, subway, parkway, passage, toll booth, tunnel, conduit, channel, pipe, aqueduct, road, roadway, railroad and/or rail-line traverse access way space, bed, surface, pavement, traverse and/or propagating on and/or off traverse access way space inclusive of, without limitation, every and all supersonic jet, speed jet, executive jet, pleasure jet, jetliner, airliner, helicopter, snowski, cycle, car, auto, van, trailer, truck, limosine, bus, rail-line, train and/or supertanker shipping products and goods transport vessels accessing every and all comprehensively suitable, generally pertinent and broadly useful airspace, airwaves, ground waves, highway, subway, parkway, passage, toll booth, tunnel, conduit, channel, pipe, aqueduct, road, roadway, railroad and/or rail-line traverse concretizing articles and access ways inclusive of waiting rooms, travel planning arrangement stations, deduction and intuitive analytical reasoning that the innovative development and technological advancement invoked within aforementioned UCMOST™ information technology is conceived, engineered, designed and developed via consumate and complete contructive reduction to practice to transcend every and all of the national sovereign borders of every and all of the industrialized, developed and developing free-market commerce and trading bloc economies throughout the world by harnessing the unlimited power of seamless and natural wrapping, twisting, convoluting, coupling and combining proprietary software and operating systems development, manufacture of hardware computing servers and devices, artificial satellite wireless and wired communications, and network routing mainframe server infrastructure capacities to concretize immediate commercialized adaptive evolution of formation and establishment of a novel, unobvious, unknown, unforeseen, unprecedented, epoch, paper-less, ease of use, fruitful, opportune, never faltering and never failing panacean cutting-edge aforementioned efficient UNIVERSAL CAPITAL MARKET™ for a necessarily integrated, critically important and increasing integral aforementioned efficient UNIVERSAL ECONOMY™. Whereas, it is an undeniable and evidentiary findings of fact, documented reference, logical scientific deduction and intuitive analytical reasoning that in purusing, effectuating and moreover conducting thorough due diligence on the technological feasibility, commercial salability and market usefulness of every and all panacean cutting-edge novel, unobvious, unknown, unforeseen, unprecedented, epoch, paper-less, ease of use, fruitful, opportune, never faltering and never failing panacean cutting-edge breakthrough utility engineering and groundbreaking technological architectural design innovation invoked within aforementioned UCMOST™ information technology which is comprehensively suitable, generally pertinent and broadly useful utility and design formulation herewith existent via consummate and complete reduction to practice wherefrom whichever applicable to every and all manufacturing, testing, developing, deploying and implementing innovative panacean cutting-edge products and services useful to every and all members of the aforementioned UNIVERSAL POPULACE™ anywhere, anytime and anyplace within, throughout and transcending the global economic marketplace enviornment, a proprietary commercial market research recognition and follow-up via primary observations wherefrom the proproprietary commercial market research study entialed, encompasses and comprised a randomly selected generic sample of twenty-two chief financial officers (CFOs) from members of the aforementioned UNIVERSAL POPULACE™ in the greater South Florida metropolitan area in the State of Florida of the so-called U.S. Whereas, it is an undeniable and evidentiary findings of fact, documented reference, logical scientific deduction and intuitive analytical reasoning that varying and multiple techniques, designs, systems, routines, devices, manners, modes, fashions, forms, formats, factors, objects, parts, segments, elements, components, constituents, ingredients, processes, methods and combinations of questions evolved as comprehensively suitable, generally pertinent and broadly useful to the further deduce every and all real-time processing and/or reprocessing of data and/or information receiver know-how suitable, pertinent and useful to assist in hereto resolving the tremendously long-held and enormously heart-felt needs in the relevant art wherefrom whichever survey questions were asked and subsequently answered by the randomly selected CFOs of twenty-two public/private organizations in the greater South Florida metropolitan geographical areas wherein a proprietary commercial market research study survey instrument was conceived, designd and utilized to attempt to gather every and all real-time processing and/or reprocessing of data and/or information receiver pertaining to every and all aspects, topics, issues and matters entailing, encompassing, comprising, involving, impacting and/or erecting information content management, financial services and aforementioned PUBLIC FINANCIALS™ instruments transactional exchange initiatives, schemes, ocurrences, happenings, interactions, processes, methods, practices, movements, proceedings, messaging, presentations, notifications, filings, submissions, records, activities, actions, events, endeavors, tasks and affairs. The quantitative percentage results herefrom referenced describe the basic results of survey automatizing real-time transmission propagating transporting transmuting partible beta particle beam gliding transponder converting receiver conduit real-time data feed retrieved, converted, formatted, processed, stored, gathered, compiled, tabulated, prepared, edited, presented, submitted, verified, validated, confirmed, broadcasted, distributed and syndicated entailing, POPULACE™ in the greater metropolitan South Florida area of the so-called U.S. The survey data responses and derived information therefrom was conducted via personal face-to-face interviews or via facsimile transmission and facsimile receipts having previously authenticated the incoming receipt of automatizing real-time transmission propagating transporting transmuting partible beta particle beam gliding transponder converting receiver conduit real-time data feed directly from the chief financial officers of the randomly selected public organization. The quantitative percentage results of this business market research study were randomly captured from a limited market sample collected wherein survey implementation occurred and transpired during the months of August and October in the year 1999. The basic quantitative percentage results from this confidential proprietary commercial market research study study do not account for the historical professional training of the senior executives which cordially accepted participation in completing the face-to-face or facsimile receipt and return delivery of the survey instruments. The employed chief financial officers which cordially, knowingly and willing accepted their confidential participation therein were identified and targeted specifically from a random variable composite of small-capitalized, mid-capitalized and large-capitalized members of the aforementioned UNIVERSAL POPULACE™ and in deriving the percentage results of the every and all real-time processing and/or reprocessing of data and/or information receiver, respective weights to account for the discrepancies in either aim, letter, nature, spirit, breadth, depth and scope of the members of the aforementioned UNIVERSAL POPULACE™ were not applied Whereas, it is an undeniable and evidentiary findings of fact, documented reference, logical scientific deduction and intuitive analytical reasoning that there can be no forms, factors, ways, parts and segemnts of assurance that every and all of the percentage results of this limited proprietary commercial market research study study accurately display the strategic initiatives, schemes, ocurrences, happenings, interactions, processes, methods, practices, movements, proceedings, messaging, presentations, notifications, filings, submissions, records, activities, actions, events, endeavors, tasks and affairs which are effectuated by these specific members of the aforementioned UNIVERSAL POPULACE™ and/or every and all other public organization pertaining to and/or are comprehensively suitable, quantities of the aforementioned fragmenting capital market inefficiencies resources to lease and/or acquire information technology business solutions which assist them as senior executinves in protecting, sustaining and expanding their treasure accounting, financial fueling and econometric energizing in a highly dynamic and inherently volatile, fragile, frigid and ruthless aforementioned fragmenting capital market inefficiencies wherefrom further they would also receive the derived utility engineering and architectural design usefulness of a novel, unobvious, unknown, unforeseen and unprecedented capacity to further protect and/or sustain the valuation of the aforementioned PUBLIC FINANCIALS™ instruments whiile rigorously pursuing strategic initiatives, schemes, ocurrences, happenings, interactions, processes, methods, practices, movements, proceedings, messaging, presentations, notifications, filings, submissions, records, activities, actions, events, endeavors, tasks and affairs to lower their cost of capital for existence in the global marketplace. The quantitative percentage results of the confidential and limited proprietary commercial market research study survey herein detailed and described are merely representative of the information derived from the response data of the twenty-two senior executive officers which participated in this proprietarily conductec and confidential market survey. It is further herein acknowledged that no direct inference and/or advanced levels of statistical correlations were attempted thereafter and herefrom which might otherwise evince further and more adequately conclusive hard facts and figures regarding the mental thought processes, emotional positions and/or future strategic initiatives, schemes, ocurrences, happenings, interactions, processes, methods, practices, movements, proceedings, messaging, presentations, notifications, filings, submissions, records, activities, actions, events, endeavors, tasks and affairs members of the aforementioned UNIVERSAL POPULACE™ sampled in this proprietary, confidential and limited proprietary commercial market research study study as it concerns and/or pertains to every and all techniques, designs, systems, routines, devices, manners, modes, fashions, forms, formats, factors, objects, parts, segments, elements, components, constituents, ingredients, processes, methods and combinations derived therefrom. This proprietary, confidential and limited proprietary commercial market research study study was tabulated utilizing high-school level mathematical driven statistical analytical assessments which need little more analytical efforts that simple summation, deduction, multiplication and division. It is undeniable and evidentiary findings of fact, documented reference, logical scientific deduction and intuitive analytical reasoning that no techniques, designs, systems, routines, devices, manners, modes, fashions, forms, formats, factors, objects, parts, segments, elements, components, constituents, ingredients, processes, methods and combinations of disclosure are herein made in either written, expressed and/or implied which breach, threaten breach and/or infringe on the limited promises of confidentiality made to the senior executive chief executive officers which cordially, knowingly and willingly participated in this limited proprietary commercial market research study study which could in every and all techniques, designs, systems, routines, devices, manners, modes, fashions, forms, formats, factors, objects, parts, segments, elements, components, constituents, ingredients, processes, methods and combinations evince knowledge and/or awareness of the named participants inclusive of, without limitation, the respective industries and sectors wherefrom thereupon members of the aforementioned UNIVERSAL POPULACE™ compete in the global marketplace under the premise of steadfast adherence and complete compliance to the limited techniques, designs, systems, routines, devices, manners, modes, fashions, forms, formats, factors, objects, parts, segments, elements, components, constituents, ingredients, processes, methods and combinations of confidentiality under which this survey instrument was implemented within the aforementioned fragmenting capital market inefficiencies environment. The various quantitative percentage results of this limited proprietary commercial market research study study evidently exemplify the obvious discrepancies and evident disparity which heretofore exists between the distinctively separate and traditionally exclusive specialty areas of public accounting and public financing via adaptive evolution aforementioned fragmenting capital market inefficiencies are comprehensively suitable, generally pertinent and broadly useful to completely resolve tremendous long-held and enormous heart-felt unmet needs in the relevant art for knowledge of aspects, topics, issues, matters, elements, components, functions, processess, procedures, designs, systems, devices, forms, factors, ways, parts, process design compositions which hereto entailing, encompassing, comprising, involving, impacting and/or effecting every and all of the preferred embodiments within aforementioned UCMOST™ information technology. Whereas, it is an undeniable and evidentiary findings of fact, documented reference, logical scientific deduction and intuitive analytical reasoning that the limited proprietary commercial market research study study inclusive of, without limitation, the actual survey instrument yes and/or no questions asked and answered by the senior executives enabled the chief finanical officers to become more equipped, well-informed, objective and aware of the potential needs to design and implement internal strategic plans to ensure steadfast adherence and full compliance to new and higher standards of reporting disclosure processes which at the time of survey implementation where yet not fully materialized in the marketplace, but thereafter with the enactment of the so-called U.S. SEC's Regulation Fair Disclosure envinced this as a findings of fact and logic. Whereas, it is an undeniable and evidentiary findings of fact, documented reference, logical scientific deduction and intuitive analytical reasoning that the quantitative percentage results of this proprietary, confidential and limited proprietary commercial market research study study may be of major importance to members of the aforementioned UNIVERSAL POPULACE™ whichever every and all are furthermore undeniably, logically, scientifically and intuitively deduced, apprehended and invoked as necessarily integrated, critically important and increasingly integral members of the aforementioned UNIVERSAL POPULACE™ wherefrom further hereto and hereafter finds of interest the perception of senior executives are comprehensively suitable, generally pertinent and broadly useful every and all techniques, designs, systems, routines, devices, manners, modes, fashions, forms, formats, factors, objects, parts, segments, elements, components, constituents, ingredients, processes, methods and combinations of increased disclosures made about performance and profitability members of the aforementioned UNIVERSAL POPULACE™ inclusive of, without limitation, every and all techniques, designs, systems, routines, devices, manners, modes, fashions, forms, formats, factors, objects, parts, segments, elements, components, constituents, ingredients, processes, methods and combinations related to the methods utilized by these senior executives to gauge both the the percentage reults derived from the automatizing real-time transmission propagating transporting transmuting partible beta particle beam gliding transponder converting receiver conduit real-time data feed retrieved, converted, formatted, processed, stored, gathered, compiled, tabulated, prepared, edited, presented, submitted, verified, validated, confirmed, broadcasted, distributed and syndicated entailing, encompassing, comprising, involving, impacting and/or effecting responses of those limited senior executive CFO's who were interested in the every and all real-time processing and/or reprocessing of data and/or information receiver of this commercial market research study which attempted to verify the beliefs of senior executives members of the aforementioned UNIVERSAL POPULACE™ are comprehensively suitable, generally pertinent and broadly useful actualizing full disclosure, best practices, best executions, enhanced fairness, simultaneous equality, full transparency, consolidated access and perpetual integration members of the aforementioned UNIVERSAL POPULACE™ in every and all basic functional elements, necessary transactions and aforementioned PUBLIC FINANCIALS™ instruments transactional exchange initiatives, schemes, ocurrences, happenings, interactions, processes, methods, practices, movements, proceedings, messaging, presentations, notifications, filings, submissions, records, activities, actions, events, endeavors, tasks and affairs, responses evinced that when inquired about the value of interim and/or quarterly aforementioned PUBLIC FINANCIALS™ statements approximately +77% of CFOs responding agreed with the finding of facts that interim so-called U.S. SEC Form 8-K with a fifteen-day time-lagged inabsentia, hardship, inanition, skidding, stalling, hesitant, holding, refusing and restraining unscheduled fifteen-day time-lagged inabsentia, hardship, inanition, skidding, stalling, hesitant, holding, refusing and restraining unscheduled aforementioned PUBLIC FINANCIALS™ statements, interim so-called U.S. SEC Form 10-Q with a standard forty-five time-lagged inabsentia, hardship, inanition, skidding, stalling, hesitant, holding, refusing and restraining aforementioned PUBLIC FINANCIALS™ statements, interim so-called U.S. SEC Form 10-QSB aforementioned PUBLIC FINANCIALS™ statements from small business registrants, interim so-called U.S. SEC Form SC-13G aforementioned PUBLIC FINANCIALS™ statements filings from beneficial owners, interim so-called U.S. SEC PUBLIC FINANCIALS™ statements comprehensively suitable, generally pertinent and broadly useful to reporting on aforementioned PUBLIC FINANCIALS™ instruments from banking, securities, insurance related public organizations inlcusive of, without limitation, transactional exchange advisers, transactional exchange companies, foundations, endownments and pension funds wherefrom hereto terminological denominatively members of the aforementioned UNIVERSAL POPULACE™, interim so-called U.S. SEC Form DEF 14-A aforementioned PUBLIC FINANCIALS™ statements comprehensively suitable, generally pertinent and broadly useful to proxy voting from members of the aforementioned UNIVERSAL POPULACE™, interim so-called U.S. SEC Form 497 aforementioned PUBLIC FINANCIALS™ statements comprehensively suitable, generally pertinent and broadly useful to initial filing registration prospectus from transactional exchange company members of the aforementioned UNIVERSAL POPULACE™, interim so-called U.S. SEC Form 24F-2NT aforementioned PUBLIC FINANCIALS™ statements of registration aforementioned PUBLIC FINANCIALS™ instruments from transactional exchange company members of the aforementioned UNIVERSAL POPULACE™, interim so-called U.S. SEC Form N-30D aforementioned PUILIC FINANCIALS™ statements comprehensively suitable, generally pertinent and broadly useful to semi-annual reporting from transactional exchange company members of the aforementioned UNIVERSAL POPULACE™, initial so-called U.S. SEC Form 3 aforementioned PUBLIC FINANCIALS™ statements comprehensively suitable, generally pertinent and broadly useful to initial sling of directors, officers and persons or public organizations owning more than 10% of any class from members of the aforementioned UNIVERSAL POPULACE™, interim so-called U.S. SEC Form 4 aforementioned PUBLIC FINANCIALS™ statements comprehensively suitable, generally pertinent and broadly useful to filing intention of disolvement of positions from directors, officers and persons and/or public organizations owning more than 10% aforementioned PUBLIC FINANCIALS™ instruments of any class from members of the aforementioned UNIVERSAL POPULACE™, wherefrom hereto are not thoroughly reviewed and/or audited by independent auditing practices contrary to the overwhelming perception from the automatizing real-time transmission propagating transporting transmuting partible beta particle beam gliding transponder converting receiver conduit real-time data feed retrieved, converted, formatted, processed, stored, gathered, compiled, tabulated, prepared, edited, presented, submitted, verified, validated, confirmed, broadcasted, distributed and syndicated entailing, encompassing, comprising, involving, impacting and/or effecting responses evinced that when inquired about the value of annual aforementioned PUBLIC FINANCIALS™ statements approximately +60% of CFOs responding do not utilize the most recently filed annual so-called U.S. SEC Form 10-K with a standard ninety-day time-lagged inabsentia, hardship, inanition, skidding, stalling, hesitant, holding, refusing and restraining, annual so-called U.S. SEC Form 20-F and/or annual so-called U.S. SEC Form 5 aforementioned PUBLIC FINANCIALS™ statements respectively from domestic, foreign registrants and/or directors, officers and persons and/or public organizations owning more than 10% aforementioned PUBLIC FINANCIALS™ instruments of any class from members of the aforementioned UNIVERSAL POPULACE™ in combination with the aforementioned PUBLIC FINANCIALS™ instruments to effectuate management decisions regarding the operating performance, transactional exchange and financial profitability members of the aforementioned UNIVERSAL POPULACE™. Furthermore, while when further inquired about the value of historical aforementioned PUBLIC FINANCIALS™ statements disclosures approximately +77% of CFOs responding believe that utilizing internal financial reports are the most valuable means of assessing the members of the aforementioned UNIVERSAL POPULACE™ bottom-line profitability. Interestingly, when inquired about the obstacles that may prohibit more financial disclosure to members of the aforementioned UNIVERSAL POPULACE™ approximately +55% of the CFOs responded they consider civil lawsuits to be a major impediment to providing more financial disclosure to members of the aforementioned UNIVERSAL POPULACE™, and when inquired about the value to public orgaizations and members of the aforementioned UNIVERSAL POPULACE™ are comprehensively suitable, generally pertinent and broadly useful full disclosure of public finanical statements with aforementioned PUBLIC FINANCIALS™ instruments, approximately +45% of CFOs PUBLIC FINANCIALS™ statements with aforementioned PUBLIC FINANCIALS™ instruments submitted to the so-called U.S. SEC. Moreover, approximately +40% of CFOs responding believe that utilization of selective disclosure aforementioned PUBLIC FINANCIALS™ statements with aforementioned PUBLIC FINANCIALS™ instruments is an injustice to members of the aforementioned UNIVERSAL POPULACE™ and does not increase the trust of confidence of these persons on senior executives, wherein this particular finding of fact inherently supported the increasing need for the so-called U.S. Securities and Exchange Commission to propagating and promulgate the now subsequently evinced regulatory enactment of Regulation Fair Disclosure (Reg. FD). Thereupon, an overwhelming approximate +86% of CFOs responding understand that major, extremely prominent and well-established transactional exchange banks are capital financing global syndicated trading Networks to enable selective members of the aforementioned UNIVERSAL POPULACE™ whichever every and all are furthermore undeniably, logically, scientifically and intuitively deduced, apprehended and invoked as necessarily integrated, critically important and increasingly integral members of the aforementioned UNIVERSAL POPULACE™ to seamlessly and naturally effectuate aforementioned PUBLIC FINANCIALS™ instruments transactions on a worldwide platform. In contrast to the perception of most securities analysts, approximately +86% of CFOs responding agree that implementing aggressive accounting policies to meet analysts quarterly and annual earnings expectations increases the probability of becoming the subject of an SEC audit and/or Investigation, while in contrast to the perception members of the aforementioned UNIVERSAL POPULACE™ whichever every and all are furthermore undeniably, logically, scientifically and intuitively deduced, apprehended and invoked as necessarily integrated, critically important and increasingly integral members of the aforementioned UNIVERSAL POPULACE™ approximately +82% of CFOs responding agree with the finding of fact that independent auditors are allowed to discuss the 10-Q and 10-K aforementioned PUBLIC FINANCIALS™ statements with public non-financial informaiton with the members of the aforementioned UNIVERSAL POPULACE™ whichever every and all are furthermore undeniably, logically, scientifically and intuitively deduced, apprehended and invoked as necessarily integrated, broadly useful to their particular public organization. Ironically, approximately +45% of CFOs responding believe that lawsuits filed by shareholders are a major impediment to providing members of the aforementioned UNIVERSAL POPULACE™ whichever every and all are furthermore undeniably, logically, scientifically and intuitively deduced, apprehended and invoked as necessarily integrated, critically important and increasingly integral members of the aforementioned UNIVERSAL POPULACE™ more accurate, timely and objective disclosures regarding the performance and profitability of public sector enterprises. In contrast to the historical and present popular perception members of the aforementioned UNIVERSAL POPULACE™, when further inquiring on the value of public financial disclosure to members of the aforementioned UNIVERSAL POPULACE™ during economic changes approximately +91% of CFOs responding believe that other members of the aforementioned UNIVERSAL POPULACE™ benefit tremendously from increased disclosures to the operating, financial and transactional exchange performance and profitability members of the aforementioned UNIVERSAL POPULACE™ during economic changes in a highway dynamic and inherently volatile, fragile, frigid and ruthless global econometric marketplace environment. To underscore the need for upgrading the systems, methods, processes, components, functions, combinations and procedures potentially offered to members of the aforementioned UNIVERSAL POPULACE™ approximately +50% of CFOs responding do not have established systems, methods, processes, components, functions, combinations and procedures present implemented to inform other members of the aforementioned UNIVERSAL POPULACE™ whichever every and all are furthermore undeniably, logically, scientifically and intuitively deduced, apprehended and invoked as necessarily integrated, critically important and increasingly integral members of the aforementioned UNIVERSAL POPULACE™ about real-time changes in the financial valuations as a response to economic instability. When further attempting to gather market-based research every and all real-time processing and/or reprocessing of data and/or information receiver on the importance of the value of public financial transactional exchange insturments within a capital market inclusive of, without limitation, its intrinsic correlation to the cost of capital of a public organization, it appears to be of enormous a sustained tempestuous devaluation in their aforementioned PUBLIC FINANCIALS™ instruments within a capital market evinces a consequential tempestuous exponentially detrimental impact to shareholder wealth maximization in a single holistically econometric marketplace environment. More interestingly, approximately +85% of CFOs responding believe the cost of capital of a public organization is a critical and variable factor are comprehensively suitable, generally pertinent and broadly useful to their day-to-day business decision-making processes and more emphatically when effectuating strategic acquisitions inclusive of, without limtation, every and all capital resource allocations in a highly dyanamic and inherently volatile, fragile, frigid and ruthless global econometric marketplace environment. When further inquiring directly about the important of the value aforementioned PUBLIC FINANCIALS™ instruments and the cost of capital in a public organization approximately +75% of the CFOs responding believe they are inclined to pursue allocation of capital resources toward implementing a long-term strategic risk management initiatives, schemes, ocurrences, happenings, interactions, processes, methods, practices, movements, proceedings, messaging, presentations, notifications, filings, submissions, records, activities, actions, events, endeavors, tasks and affairs to sustain the valuation of the aforementioned PUBLIC FINANCIALS™ instruments against to tempestuous exponentially detrimental exponential increases in systematic volatility within a capital market and protect and/or lower every and all tempestuous exponentially debilitating exponential increases in the cost of capital in a in a highly dyanamic and inherently volatile, fragile, frigid and ruthless global econometric marketplace environment. As a conclusive presentation of the percentage results of this commercial market research study and most importantly, along this same line of inquiry approximately +90% of the CFOs responding believe every and all sustenance of the tempestuous exponentially detrimental exponential increases in systematic volatility and protection against the tempestuous exponentially debilitating exponential increases in the cost of capital is extremely critical and inestimable in value are comprehensively suitable, generally pertinent and broadly useful to the short and long-term profitability inclusive of, without limitation, the short and long-term existence of every and all public organization which competes for resources in

2. Public Capital Market—U.S. History

Today's capital market is the result of an adaptive evolutionary restructuring in the world of finance propagating and promulgated in the early-1970's by an elite contingent of academic scholars. These academic scholars eventually overcame the stronghold of the old guard on so-called Wall Street with their messages of heretofore unimaginable simplicity. Their unyielding strive was to ensure the principle laws of economics, which stipulate that gaining an advantage over skilled and knowledgeable competitors in a free market is extraordinarily difficult were connected with the principle laws of finance, which stipulate that innately there can be no reward without risk and intrinsically historical performance is no indication of future stability withwithin a capital market environment. It is clear that the abstract conceptual thoughts processes of this elite contingent of academic scholars was that by combining the principle lawg of economics and finance they would offer a greater understanding of what an aforementioned efficient UNWERSAL CAPITAL MARKET™ represented for a single holistically econometric marketplace environment wherefrom thereby it might be feasible to engage in devising new methods and novel processes for the members of the aforementioned UNIVERSAL POPULACE™ to manage their capital resources. The justifiable reasoning which led to the world of modem world of finance came to the forefront because of the work initiatives, schemes, ocurrences, happenings, interactions, processes, methods, practices, movements, proceedings, messaging, presentations, notifications, filings, submissions, records, activities, actions, events, endeavors, tasks and affairs of these scholars and the impact of the greatest so-called bear market since the Great Crash of 1929 which evidently occurred during the years of 1973-74. In fact, premised on the justifiable basis and logical reasoning of increased cost of living and devalution in bond debt aforementioned PUBLIC FINANCIALS™ instruments, the so-called bear market of 1973-74 was in many techniques, designs, systems, routines, devices, manners, modes, fashions, forms, formats, factors, objects, parts, segments elements, components, constituents, ingredients, processes, methods and combinations considerably worse than during 1973-74 stock equity market valuations had fallen by more than forty percent from their previous two-year highs. This historic period in so-called U.S. history that occurred in the early-1970's devised enormous distress in the world of finance as many well-respected banks, major industrial corporations and even the largest state governments stood at the precipice of bankruptcy, and the continuencies of independent invesment advisors, bank trust departments, and managers of insurance company portfolios and university not-for-profit endownments were in total disarray. It was only then that working practitioners began to pay inquisitive and extensive attention to the scholars' abstract combinatorial academic theories pertaining to the principle laws of economics and finance. Heretofore, these academic theorists whose professional efforts were predominately mathematically oriented had only found their way to publication in leading academic journals on economics and transactional exchange management. This elite contingent of academic scholars had worked on their abstract theories and pragmatic conceptual notions for nearly twenty years, but without the crises during 1973-74 most working practitioners may never have changed their unsophisticated ways of managing capital at the expense of their clients' interests, assets and equities, whereupon various innovations took hold enabling larger volumes aforementioned PUBLIC FINANCIALS™ instruments to be transacted and exchanged around the world at speeds previously unforeseen by members of the aforementioned UNIVERSAL POPULACE™. In today's present day world of modern finance the volumes aforementioned PUBLIC FINANCIALS™ instruments transacted and exchanged are phenomenal inclusive of the number members of the aforementioned UNIVERSAL POPULACE™ with on-line access to seamlessly and naturally their own positions in their portfolios has expanded at exponential rates of growth. Whereas, it is an undeniable and evidentiary findings of fact, documented reference, logical scientific deduction and intuitive analytical reasoning that an article titled, the Wild, Wired World of Electronic Exchange, published in Institutional Depositors magazine in 1989 set forth a scenario for the future of a single holistically econometric marketplace environment of new age finance wherefrom hereto it was reported that members of the aforementioned UNIVERSAL POPULACE™ should say good-bye to the heady roar of the exchange floor and forget the terse shouting of two comprehend the aforementioned fragmenting capital market inefficiencies fails to impart that although without question it appears under guise to be the most dazzling creation of our modern world, it is clearly an undeniable and evidentiary findings of fact, documented reference, logical scientific deduction and intuitive analytical reasoning that it completely enthralls, engulfs, oppresses and continuously preys upon the members of the aforementioned UNIVERSAL POPULACE™ with inefficient, ineffective, dysfunctional and fragmented Networks of varying members of the aforementioned UNIVERSAL POPULACE™ and their commission income earning so-called registered retail representatives which engage in unfair, undeniable, unnecessary, unwarranted, illogical, unjustifiable, and predatory competitive practices which derogatively under fraudulent guise serve unknowing, unsophisticated, unletter and unpolished members of the aforementioned UNIVERSAL POPULACE™ in a obtrusive and fraudulent capacity with ancient history fragmenting market inefficiencies inefficiencies. These members of the aforementioned UNIVERSAL POPULACE™ and their so-called registered retail representative completely enthralls, engulfs, oppresses and continuously preys upon the members of the aforementioned UNIVERSAL POPULACE™ with multivariate and multidimensional inefficient, ineffective, dysfunctional and fragmented techniques, designs, systems, routines, devices, manners, modes, fashions, forms, formats, factors, objects, parts, segments, elements, components, constituents, ingredients, processes, methods and combinations of every and all real-time processing and/or reprocessing of data and/or information receiver, financial services aforementioned PUBLIC FINANCIALS™ instruments transactional exchange initiatives, schemes, ocurrences, happenings, interactions, processes, methods, practices, movements, proceedings, messaging, presentations, notifications, filings, submissions, records, activities, actions, events, endeavors, tasks and affairs. This capital marketplace environment innately obtrusively misinforms and irresponsibly parasitically feeds of unknowing, unsophisticated, unlettered, ignorant, uneducated and unpolished members of the aforementioned UNIVERSAL POPULACE™ under the guise of preconceived servile intentions to deposit their hard earned wages in a liquid, transparent and efficient members of the aforementioned UNIVERSAL POPULACE™, when it is clearly an and integrated capital market heretofore clearly does not exist within the aforementioned fragmenting capital market inefficiencies. It is further an undeniable and evidentiary findings of fact, documented reference, logical scientific deduction and intuitive analytical reasoning that aforementioned fragmenting capital market inefficiencies is not much different from the highly speculative, misconstrued and confusion ridden and puzzling UNIVERSAL CAPITAL MARKET™ pertaining to aforementioned PUBLIC FINANCIALS™ instruments which confronted so-called U.S. President Franklin D. Roosevelt prior to and subsequent to his strive at promulgating comprehensive and federally mandated legislative acts of so-called U.S. congress in pursuit of necessary and wide-spread reform within the aforementioned fragmenting capital market inefficiencies of the late 1920's and early 1930's which traditionally concretize inefficient, ineffective, dysfunctional and fragmented vast networks of antiquated, archaic, ancient history and superannuated aforementioned PUBLIC FINANCIALS™ organizations which heretofore propagating aforementioned fragmenting capital market inefficiencies via the communicating conduits of conceptual aids within a single holistically econometric marketplace environment. Then so-called U.S. President Franklin D. Roosevelt also possessed the courage of conviction to propagating the hertofore and present aforementioned fragmenting capital market inefficiencies in a direction of establishing laws, governing rules and authoritative regulations formembers of the aforementioned UNIVERSAL POPULACE™ in pursuit of currency from members of the aforementioned UNIVERSAL POPULACE™ via access to the aforementioned fragmenting capital market inefficiencies. Then so-called U.S. President Franklin D. Roosevelt presumed that laws, governing rules and authoritative regulations enabled compliance to full disclosure within the aforementioned fragmenting capital market inefficiencies without compromising simplification and streamlined procedures requiting members of the aforementioned UNIVERSAL POPULACE™ to register their aforementioned PUBLIC FINANCIALS™ instruments and subsequently list these aforementioned PUBLIC FINANCIALS™ instruments on a licensed so-called U.S. securities exchange. Then so-called U.S. President Franklin D. Roosevelt displayed leadership in promulgating establishment of legal, regulatory and administrative forms, formats, factors, objects, parts, segments, elements, components, constituents, ingredients, processes, methods and combinations pertaining to the aforementioned fragmenting capital market inefficiencies. Although then so-called U.S. President Franklin D. Roosevelt's leadership initiatives, schemes, ocurrences, happenings, interactions, processes, methods, practices, movements, proceedings, messaging, presentations, notifications, filings, submissions, records, activities, actions, events, endeavors, tasks and affairs were unprecedented his work efforts nevertheless engraved a symbol of goodness in the letter, spirit and nature of what an aforementioned efficient UNIVERSAL CAPITAL MARKET™ must necessary and perpetually represent for so-called U.S. and the world at large. Today, irrespective of the multivariate laws, governing rules and authoritative regulations whose foundation is engraved in nearly seventy years of legal precedent which prevents and precludes the aforementioned fragmenting capital market inefficiencies the so-called U.S. continues to live in an capital market completely enthralled, engulfed and oppressed with rampant injustices and inequalities embodied within the aforementioned fragmenting capital market inefficiencies which are referenced and documented across-the-board to every and all multifaceted industries and multidimensional sectors which transcend the national sovereign borders of every and all of the industrialized, developed and developing free-market commerce and trade bloc economies of a single holistically econometric marketplace environment throughout the world. A more comprehensive analysis of the legislative acts of congress promulgated during this period of so-called U.S. history, we acknowledge the so-called U.S. Securities Act of 1933 and the so-called U.S. Securities Exchange Act of 1934. Each of these legislative acts of congress came into being in response to the heavy stock equity speculation that engulfed the 1920's in the so-called U.S. which subsequently led to the depression era in the so-called U.S. The imminent result of this period of unregulated and administered stock equity speculation in so-called U.S. history culminated in the Great Crash of the stock market in October 1929. The stock equity aforementioned PUBLIC FINANCIALS™ instruments tempestuous devaluation of October 1929 was subsequently coined the beginning of the Great Depression in the so-called U.S. Although the so-called U.S. Securities Act of 1933 and establishing the foundation of legal precedent pertaining to every and all techniques, designs, systems, routines, devices, manners, modes, fashions, forms, formats, factors, objects, parts, segments, elements, components, constituents, ingredients, processes, methods and combinations related to the aforementioned fragmenting capital market inefficiencies. The so-called U.S. Securities Act of 1933 regulates the initial distribution of public organization equity and debt UNIVERSAL CAPITAL MARKET™ security issues. The so-caned U.S. Securities Act of 1933 requires a public organization to register their aforementioned PUBLIC FINANCIALS™ instruments and make full disclosure of their aforementioned PUBLIC FINANCIALS™ statements inclusive of seamlessly and naturally wrapped, twisted, mixed, convoluted, embroidered and combined in connection with aforementioned PUBLIC FINANCIALS™ instruments before their aforementioned PUBLIC FINANCIALS™ instruments can be offered to members of the aforementioned UNIVERSAL POPULACE™. The so-called U.S. Securities Exchange Act of 1934 requires periodic updating of every and all techniques, designs, systems, routines, devices, manners, modes, fashions, forms, formats, factors, objects, parts, segments, elements, components, constituents, ingredients, processes, methods and combinations aforementioned PUBLIC FINANCIALS™ statements seamlessly and naturally wrapped, twisted, mixed, convoluted, embroidered and combined in connection with aforementioned PUBLIC FINANCIALS™ instruments from members of the aforementioned UNIVERSAL POPULACE™ whose aforementioned PUBLIC FINANCIALS™ instruments are registered and subsequently listed on a licensed so-called U.S. Securities Exchange. The so-called U.S. Securities Exchange Act of 1934 also devised the so-called U.S. Securities and Exchange Commission (SEC) assigning solely to it as an independent agency of the so-called U.S. federal government the highest degree of responsibility in administering both the so-called U.S. Securities Act of 1933 and the so-called U.S. Securities Exchange Act of 1934, thereof ensuring independent regulatory power and authority over the aforementioned fragmenting capital market inefficiencies in the so-called U.S. SEC. The so-called U.S. SEC has vested in its legal charter the sole responsibility of upholding the so-called U.S. securities laws that regulate the transactional exchange aforementioned malicious, condescending, untruthful, insolent, inefficient, incognizant, ineffective, fragmenting, unlettered, unpolished, presumptuous, portentous, pretentious, fruitless, disparate, antiquated, archaic, ancient history and superannuated so-called U.S. territories. The so-called U.S. SEC also has the vested independent regulatory power and governing authority to determine the aforementioned PUBLIC FINANCIALS™ statements inclusive of seamlessly and naturally wrapped, twisted, mixed, convoluted, embroidered and combined in connection with aforementioned PUBLIC FINANCIALS™ instruments disclosures that a public organization registering aforementioned PUBLIC FINANCIALS™ instruments and listing them on a so-called U.S. securities exchange must make to it as an independent regulatory authority and herewith members of the aforementioned UNIVERSAL POPULACE™. It is an undeniable and evindentiary findings of fact, documented reference, logical scientific deduction and intuitive analytical reasoning that premised on vested legal charter and independent power over the aforementioned fragmenting capital market inefficiencies that the so-called U.S. SEC and the so-called U.S. Department of Treasury are the ultimate legally vested and governing authorities of a capital market within the United State of America. Moreover, it is an undeniable and evidentiary findings of fact, documented reference, logical scientific deduction and intutive analytical reasoning that the exclusively held independent regulatory power of the so-called U.S. SEC overshadows every and all other independent departments and/or agencies who may, directly or indirectly, be involved in oversight responsibility of varying industries and sectors which necessarily participate within and propagate the aforementioned fragmenting capital market inefficiencies. The so-called U.S. Securities Act of 1933 and the so-called U.S. Securities Exchange Act of 1934 in combination requires full disclosure from members of the aforementioned UNIVERSAL POPULACE™ as a premise of their initial registration aforementioned PUBLIC FINANCIALST instruments, subsequent distribution of their PUBLIC FINANCIALS™ instruments, eventual syndication aforementioned PUBLIC FINANCIALS™ instruments inclusive of, without limitation, the continual listing aforementioned PUBLIC FINANCIALS™ instruments on a licensed so-called U.S. Securities Exchange. It is evident that at the enterprise, guiding principles and standards pertinent to measurement, reporting and auditing to fully promulgate its vested legal charter and independent governing power and regulatory authority to assure so-called U.S. and members of the aforementioned UNIVERSAL POPULACE™ of full disclosure aforementioned PUBLIC FINANCIALS™ statements inclusive of seamlessly and naturally wrapped, twisted, mixed, convoluted, embroidered and combined in connection with aforementioned PUBLIC FINANCIALS™ instruments requited from members of the aforementioned UNIVERSAL POPULACE™ inclusive of, without limitation, fully capacity utilization of best practices and best executions of every and all techniques, designs, systems, routines, devices, manners, modes, fashions, forms, formats, factors, objects, parts, segments, elements, components, constituents, ingredients, processes, methods and combinations of factual holistically steady state continuous spectrum ubiquitous indistinguishably synchronous needs involving aforementioned UCMOST™ real-time processing and/or reprocessing of data and/or information content management, financial services and aforementioned PUBLIC FINANCIALS™ instruments transactional exchange initiatives, schemes, ocurrences, happenings, interactions, processes, methods, practices, movements, proceedings, messaging, presentations, notifications, filings, submissions, records, activities, actions, events, endeavors, tasks and affairs in every and all obscurant, irresponsible, feculent, irrational, feckless, disrespectful, mendacious, ignorant, malicious, condescending, untruthful, insolent, inefficient, incognizant, ineffective, fragmenting, unlettered, unpolished, presumptuous, portentous, pretentious, fruitless, disparate, antiquated, archaic, ancient history and superannuated so-called U.S. territories involving every and all aforementioned PUBLIC FINANCIALS™ instruments. In compromise premised on its subtle beginnings, the so-called U.S. SEC passively relegated its vested legal charter and independent governing power and regulatory authority to facilitate a positive enabling working relationship with the distinctively separate and traditionally exclusive specialty areas of the efficient, effective, functional and integrated streamlined, alternating scale, inseparable, seamless and natural wrapping, interlacing, coiling, coupling, combining and interlocking techniques, designs, systems, routines, devices, manners, modes, fashions, forms, formats, factors, objects, automatizing real-time holistically steady state synchronized ubiquitous continuum real-time rhombus microprocessing instantaneous transmission and receiver transforming traverse conduit aforementioned UCMOST™ real-time processing and/or reprocessing of every and all public accounting, transport reconciling, independent auditing and financial reporting inclusive of efficient, effective, functional and integrated streamlined, alternating scale, inseparable, seamless and natural wrapping, interlacing, coiling, coupling, combining and interlocking technique; designs systems, routines devices, manners, modes, fashions, forms, formats, factors, objects, parts, segments, elements, components, constituents, ingredients, processes, methods and combinations entailing, encompassing, comprising, involving, impacting and/or effecting automatizing real-time holistically steady state synchronized ubiquitous continuum real-time rhombus microprocessing instantaneous transmission and receiver transforming traverse conduit aforementioned UCMOST™ real-time processing and/or reprocessing of every and all order-entry quotation, matching, clearance, execution, settlement and exchange of insurance, risk financing, credit, cash management, investment banking, and PUBLIC FINANCIALS™ instruments transactional activities. The so-called U.S. SEC is now approximately seventy years in operation, and its legal basis and justifiable reasoning for its purpose of existence is premised on legislative precedent of the so-called U.S. Securities Act of 1933s of congress, inclusive of every and all techniques, designs, systems, routines, devices, manners, modes, fashions, forms, formats, factors, objects, parts, segments, elements, components, constituents, ingredients, processes, methods and combinations pertaining to its vested legal charter and independent governing power and regulatory authority over every and all techniques, designs, systems, routines, devices, manners, modes, fashions, forms, formats, factors, objects, parts, segments, elements, components, constituents, ingredients, processes, methods and combinations concerning its responsibilities, duties and obligations to the aforementioned fragmenting capital market inefficiencies, so-called U.S. depositors and/or the citizens in members of the aforementioned UNIVERSAL POPULACE™ of the so-called U.S. should never be questioned, objected to and/or circumvented by every and all other so-called U.S. federal independent agencies, so-called U.S. federal congressional senate and house called U.S. state congressional senate and house representatives, so-called U.S. state governors, so-called U.S. state bench supreme, circuit or district trial court judges, every and all industry and/or sector oriented initiatives, schemes, ocurrences, happenings, interactions, processes, methods, practices, movements, proceedings, messaging, presentations, notifications, filings, submissions, records, activities, actions, events, endeavors, tasks and affairs of lobbying groups, political appointees, publicly elected officials, public civil bureaucratic servants, members of the aforementioned UNIVERSAL POPULACE™, senior executives, board directors, audit committee members, independence committee members, compensation committee members, midlevel executive managers, personnel employees, internal auditors, public accountants, independent auditors, legal counsel, and/or every and all forms of institutional money managers, financial analysts, so-called U.S. licensed aforementioned PUBLIC FINANCIALS™ instruments exchanges, so-called U.S. aforementioned PUBLIC FINANCIALS™ instruments clearing firms, so-called U.S. state oriented UNIVERSAL CAPITAL MARKET™ banking administrative authorities, so-called U.S. state oriented UNIVERSAL CAPITAL MARKET™ insurance administrative authorities, so-called U.S. state oriented aforementioned PUBLIC FINANCIALS™ instruments administrative authorities, so-called U.S. depositors, members of the aforementioned UNIVIPSAL POPULACE™, members of the aforementioned UNIVERSAL POPULACE™ at large or every and all hereto members of the aforementioned UNIVERSAL POPULACE™ encompassing and/or involved in the banking, insurance and securities industries and sectors inclusive of, without limitation, every and all members of the aforementioned UNIVERSAL POPULACE™ pertaining to the distinctively separate and traditionally exclusive specialty areas of the efficient, effective, functional and integrated streamlined, alternating scale, inseparable, seamless and natural wrapping, interlacing, coiling, coupling, combining and interlocking techniques, designs, systems, routines, devices, manners, modes, fashions, forms, formats, factors, objects, parts, segments, elements, components, constituents, ingredients, processes, methods and combinations entailing, encompassing, comprising, involving, impacting and/or effecting automatizing real-time holistically steady state synchronized ubiquitous continuum real-time rhombus public accounting, transport reconciling, independent auditing and financial reporting inclusive of efficient, effective, functional and integrated streamlined, alternating scale, inseparable, seamless and natural wrapping, interlacing, coiling, coupling, combining and interlocking techniques, designs, systems, routines, devices, manners, modes, fashions, forms, formats, factors, objects, parts, segments, elements, components, constituents, ingredients, processes, methods and combinations entailing, encompassing, comprising, involving, impacting and/or effecting automatizing real-time holistically steady state synchronized ubiquitous continuum real-time rhombus microprocessing instantaneous transmission and receiver transforming traverse conduit aforementioned UCMOST™ real-time processing and/or reprocessing of every and all order-entry quotation, matching, clearance, execution, settlement and exchange of insurance, risk financing, credit, cash management, transactional exchange banking, and aforementioned PUBLIC FINANCIALS™ instruments transactional exchange initiatives, schemes, ocurrences, happenings, interactions, processes, methods, practices, movements, proceedings, messaging, presentations, notifications, filings, submissions, records, activities, actions, events, endeavors, tasks and affairs whether or not every and all are involved in every and all aforementioned UCMOST™ real-time processing and/or reprocessing of data and/or information content management, financial services and transactional exchange unmet needs embroidering aforementioned PUBLIC FINANCIALS™ instruments transactional exchange services whether in domestic and/or foreign territories and whether or not every and all in letter, spirit, nature, scope, breadth and/or depth reside and/or operate anywhere in the world pertaining to executive, political, legislative, judicial, regulatory, social, economic, operational, financial and/or transactional exchange initiatives, schemes, ocurrences, happenings, interactions, processes, methods, practices, movements, proceedings, messaging, presentations, notifications, filings, submissions, records, activities, actions, events, endeavors, tasks and affairs. The adaptive evolutionary positive enabling impact of innovations in personal computer proprietary software programs and proprietary operating systems, hardware manufacture, communications infrastructure and network routing capacities in the three decades hereto now enable the so-called U.S. SEC to recapture its vested legal charter and independent yet to be emancipate and enfranchised from the harming, damaging, inuring, insistent, insinuating, imposing, pestilent, impetuous, importune, pestiferous, condescending and insolent enthralling, hindering, entrapping, pretending, miring, fatiguing, maleficience, harassing, engulfing, pressing, malevolent, presuming, imprinting, malicious, suffocating, miring, strangling, repressing, entangling, pestering and oppressing which are traditionally concretizing via inefficient, ineffective, dysfunctional and fragmented vast networks of antiquated, archaic, ancient history and superannuated aforementioned PUBLIC FINANCIALS™ organizations which heretofore continuously, arrogantly, imprudently, irrationally and irresponsibly engage in propagating aforementioned fragmenting capital market inefficiencies via the communicating conduits of conceptual aids within a single holistically econometric marketplace environment. Once invoking the unequivocal absolute resolution concretizing via aforementioned UCMOST™ information technology the imminent existence of a seamless modernization of a globally recognized free-market enterprise whose purpose is to ensure that the so-called U.S. SEC in the so-called U.S., and every other counterpart transnational governing body and regulatory authority has at its disposal technological innovations whose innate letter, spirit, nature, breadth, depth and scope offers a high-caliber technological solution necessary heretofore requisited within the aforementioned fragmenting capital market inefficiencies. The combinatorial impact of free-mayed and free-market integration pertaining to independently initiated and self-developed innovative technologies in combination with the so-called U.S. SEC's vested legal charter and independent governing power and regulatory authority imminently paves the road toward formation of a new theater of operations premised on an innovative panacean cutting-edge technological oriented digital bridge platform which establishes, propagating, promulgating and proclaiming higher standards of full disclosure, best practices, best executions, enhanced fairness, simultaneous equality, full transparency, consolidated access and perpetual integration of members members of the aforementioned UNIVERSAL POPULACE™ evincing efficient, effective, functional and integrated streamlined, alternating scale, inseparable, seamless and natural wrapping, interlacing, coiling, coupling, combining and interlocking techniques, designs, systems, routines, entailing, encompassing, comprising, involving, impacting and/or effecting automatizing real-time holistically steady state synchronized ubiquitous continuum real-time rhombus microprocessing instantaneous transmission and receiver transforming traverse conduit aforementioned UCMOST™ real-time processing and/or reprocessing of every and all public accounting, transport reconciling, independent auditing and financial reporting inclusive of efficient, effective, functional and integrated streamlined, alternating scale, inseparable, seamless and natural wrapping, interlacing, coiling, coupling, combining and interlocking techniques, designs, systems, routines, devices, manners, modes, fashions, forms, formats, factors, objects, parts, segments, elements, components, constituents, ingredients, processes, methods and combinations entailing, encompassing, comprising, involving, impacting and/or effecting automatizing real-time holistically steady state synchronized ubiquitous continuum real-time rhombus microprocessing instantaneous transmission and receiver transforming traverse conduit aforementioned UCMOST™ real-time processing and/or reprocessing of every and all order-entry quotation, matching, clearance, execution, settlement and exchange of insurance, risk financing, credit, cash management, investment banking and aforementioned PUBLIC FINANCIALS™ instruments to concretize the aforementioned fragmenting capital market inefficiencies which so-called U.S. President Franklin D. Roosevelt set forth the legal basis and justifiable reasoning for by promulgating the so-called U.S. federal congressional legislative initiatives which established the legal precedent of the so-called U.S. Securities Act of 1933, the so-called U.S. Securities Exchange Act of 1934, and the so-called U.S. SEC approximately seventy years hereto. The so-called U.S. SEC recently began to subtly shift and adjust its long-held position on passively delegating its vested legal charter and independent governing power and regulatory authority to the professions involved in the efficient, effective, functional and integrated streamlined, alternating scale, inseparable, seamless and natural wrapping, interlacing, coiling, coupling, combining and interlocking techniques, designs, systems, routines, devices, manners, modes, fashions, forms, formats, factors, objects, parts, segments, elements, components, constituents, ingredients, processes, methods and combinations entailing, encompassing, comprising, involving, impacting and/or effecting automatizing real-time aforementioned UCMOST™ real-time processing and/or reprocessing of every and all public accounting, transport reconciling, independent auditing and financial reporting inclusive of efficient, effective, functional and integrated streamlined, alternating scale, inseparable, seamless and natural wrapping, interlacing, coiling, coupling, combining and interlocking techniques, designs, systems, routines, devices, manners, modes, fashions, forms, formats, factors, objects, parts, segments, elements, components, constituents, ingredients, processes, methods and combinations entailing, encompassing, comprising, involving, impacting and/or effecting automatizing real-time holistically steady state synchronized ubiquitous continuum real-time rhombus microprocessing instantaneous transmission and receiver transforming traverse conduit aforementioned UCMOST™ real-time processing and/or reprocessing of every and all order-entry quotation, matching, clearance, execution, settlement and exchange of insurance, risk financing, credit, cash management, investment banking, and PUBLIC FINANCIALS™ instruments transactional activities. Whereas, it is an undeniable and evidentiary findings of fact, documented reference, logical scientific deduction and intuitive analytical reasoning that the premised on documented references and evidentiary regulatory initiatives that the so-called U.S. SEC is maying and capable of reassessing its full reign of every and all techniques, designs, systems, routines, devices, manners, modes, fashions, forms, formats, factors, objects, parts, segments, elements, components, constituents, ingredients, processes, methods and combinations pertaining to its vested legal charter and independent governing power and regulatory authority to serve the exclusive interests of so-called U.S. depositors, so-called U.S. citizen taxpayers, and members of the aforementioned UNIVERSAL POPULACE™ Prom around the world which necessarily require enhanced fairness, simulteanoues equality, full transparency, consolidated access and perpetual integration to pertinent every and all techniques, designs, systems, routines, devices, manners, modes, fashions, forms, formats, factors, objects, parts, segments, elements, components, constituents, ingredients, processes, methods and combinations aforementioned PUBLIC FINANCIALS™ statements seamlessly and naturally wrapped, twisted, mixed, convoluted, embroidered and combined in connection with aforementioned PUBLIC FINANCIALS™ instruments laws, governing rules and authoritative regulations was consequentially less than would otherwise be expected due to the prevailing political, social, financial, and economic forces that preempted stipulations pertaining to complete adherence, and fully enforceable compliance pertaining to the efficient, effective, functional and integrated streamlined, alternating scale, inseparable, seamless and natural wrapping, interlacing, coiling, coupling, combining and interlocking techniques, designs, systems, routines, devices, manners, modes, fashions, forms, formats, factors, objects, parts, segments, elements, components, constituents, ingredients, processes, methods and combinations entailing, encompassing, comprising, involving, impacting and/or effecting automatizing real-time holistically steady state synchronized ubiquitous continuum real-time rhombus microprocessing instantaneous transmission and receiver transforming traverse conduit aforementioned UCMOST™ real-time processing and/or reprocessing of every and all public accounting, transport reconciling, independent auditing and financial reporting inclusive of efficient, effective, functional and integrated streamlined, alternating scale, inseparable, seamless and natural wrapping, interlacing, coiling, coupling, combining and interlocking techniques, designs, systems, routines, devices, manners, modes, fashions, forms, formats, factors, objects, parts, segments, elements, components, constituents, ingredients, processes, methods and combinations entailing, encompassing, comprising, involving, impacting and/or effecting automatizing real-time holistically steady state synchronized ubiquitous continuum real-time rhombus microprocessing instantaneous transmission and receiver transforming traverse conduit aforementioned UCMOST™ real-time processing and/or reprocessing of every and all order-entry quotation, matching, clearance, execution, settlement and exchange of insurance, risk financing, credit, cash management, investment banking, and PUBLIC FINANCIALS™ instruments transactional activities. Historically, large-scale lobbying efforts from interests groups, in and around the geographical area of Washington, District of Columbia, the so-called U.S. national capital, have traditionally preempted and enthralled the so-called U.S. SEC from serving its true mission of serving the exclusive interests of so-called U.S. depositors and the citizens of the so-called U.S., premised on their rigid positions and illogical reasoning of these full-scale lobbying interests groups calling for never ensuring nearly seventy years ago as legal precedent. It is now clearer than ever before in so-called U.S. history that free-market driven and composed initiatives, schemes, ocurrences, happenings, interactions, processes, methods, practices, movements, proceedings, messaging, presentations, notifications, filings, submissions, records, activities, actions, events, endeavors, tasks and affairs from free-market private enterprise initiatives, schemes, ocurrences, happenings, interactions, processes, methods, practices, movements, proceedings, messaging, presentations, notifications, filings, submissions, records, activities, actions, events, endeavors, tasks and affairs involved in self-developing innovative information technology facilitates the so-called U.S. SEC's ability to utilize its vested legal charter and independent governing power and regulatory authority over the aforementioned fragmenting capital market inefficiencies by ensuring that proprietary software programs and proprietary operating systems are implemented throughout the aforementioned fragmenting capital market inefficiencies and that such technological capacities are made available in every and all coupling and combinatorial techniques, designs, systems, routines, devices, manners, modes, fashions, forms, formats, factors, objects, parts, segments, elements, components, constituents, ingredients, processes, methods and combinations are brought to the forefront. The so-called U.S. SEC has evidently displayed its logical stance on repossessing its vested legal charter and independent governing power and regulatory authority in promulgating the rights and interests of so-called U.S. depositors in accordance with the vision of so-called U.S. President Franklin D. Roosevelt as such evidentiary initiatives have displayed via the so-called U.S. SEC's recent adoption and enactment of Regulation Fair Disclosure (Reg. FD). A Columbia University professor of so-called U.S. securities laws recently commented on the so-called U.S. SEC's concerted effort at ensuring complete adherence and fully enforceable compliance with so-called U.S. securities laws, governing rules and authoritative regulations from each and every public organization which necessarily participates within the aforementioned fragmenting capital market inefficiencies by stating that although the so-called U.S. SEC's rules and regulations inclusive of so-called U.S. securities laws always prohibited selective disclosure, the independent governing agency never spelled out what selective disclosure actually was or how it would enforce effective adoption of Reg. FD on Oct. 23, 2000 ensures that utilization of selected disclosure aforementioned PUBLIC FINANCIALS™ statements inclusive of seamlessly and naturally wrapped, twisted, mixed, convoluted, embroidered and combined in connection with aforementioned PUBLIC FINANCIALS™ instruments distributed to pension managers, mutual funds, transactional exchange advisors, transactional exchange bankers, securities analysts and high-net worth depositors by the senior executives members of the aforementioned UNIVERSAL POPULACE™ is unequivocally illegal. Although so-called U.S. securities laws always dictated that selective disclosure of every and all techniques, designs, systems, routines, devices, manners, modes, fashions, forms, formats, factors, objects, parts, segments, elements, components, constituents, ingredients, processes, methods and combinations aforementioned PUBLIC FINANCIALS™ statements seamlessly and naturally wrapped, twisted, mixed, convoluted, embroidered and combined in connection with aforementioned PUBLIC FINANCIALS™ instruments from members of the aforementioned UNIVERSAL POPULACE™ was illegal, the so-called U.S. SEC never knew what it would require to ensure complete adherence and fully enforceable compliance with the strict legal precedent of the so-called U.S. Securities Act of 1933 and the so-called U.S. Securities Exchange Act of 1934, inclusive of every and all other such so-called U.s. securities laws, governing rules and authoritative regulations which have been developed heretofore within the aforementioned fragmenting capital market inefficiencies. Although most lobbying interest groups from the banking, securities and insurance industry professions always sought to promulgate initiatives to overcome Glass-Steagall barriers to entry which prevented the umbrella offering of full-service banking, securities and insurance products and services to so-called U.S. depositors it is difficult to understand why these same industry group lobbying efforts would work against ensuring complete adherence and fully enforceable compliance to every and all obscurant, irresponsible, feculent, irrational, feckless, disrespectful, mendacious, ignorant, malicious, condescending, untruthful, insolent, inefficient, incognizant, ineffective, fragmenting, unlettered, unpolished, presumptuous, portentous, pretentious, fruitless, disparate, antiquated, archaic, ancient history and superannuated so-called U.S. securities laws, governing rules findings of fact, documented reference, logical scientific deduction and intuitive analytical reasoning that every and all novel and panacean cutting-edge information technology are via adaptive evolution turning upside and down every and all archaic and long-standing technologies, methodologies, processes and procedures entailing, encompassing, comprising, involving, impacting and/or effecting every and all traditional manners, methods, and processes are comprehensively suitable, generally pertinent and broadly useful to the dissemination aforementioned PUBLIC FINANCIALS™ statements inclusive Of seamlessly and naturally wrapped, twisted, mixed, convoluted, embroidered and combined in connection with aforementioned PUBLIC FINANCIALS™ instruments to members of the aforementioned UNIVERSAL POPULACE™ . The archaic and long-standing technologies, methodologies, processes and procedures heretofore utilized to conduct and execute trade, transport goods and render every and all techniques, designs, systems, routines, devices, manners, modes, fashions, forms, formats, factors, objects, parts, segments, elements, components, constituents, ingredients, processes, methods and combinations of professional services offered to members of the aforementioned UNIVERSAL POPULACE™ are hereby transfigured, reconfigured, transformed and transmuted to supplant every and all so-called wire jack line and/or so-called wireless heretofore inefficient, portentous and fruitless public accounting, transport reconciling, independent auditing and financial reporting to unequivocally supplant the antiquated, archaic, ancient history and superannuated inefficient, ineffective, dysfunctional and fragmenting technologies, methodologies, processes, capcities, combinations and/or protocols to propagate heretofore faculties of communicating, energizing, fueling, broadcasting, transporting, distributing and financing heretofore propagating via the inefficient, ineffective, dysfunctional and fragmenting so-called Internet in connection with and/or inclusive of, without limitation, via the inefficient, ineffective, dysfunctional and fragmenting so-called World Wide Web. Whereas, UCMOST information technology evincing UCMOST™ real-time processing and/or reprocessing invokes an absolute resolution to every and all so-called recent advancements to concretize aforementioned efficient UNIVERSAL CAPITAL MARKET™ communications technologies propagating time rhombus microprocessing instantaneous transmission and receiver transforming traversal conduits via the novel aforementioned UCMOST™ real-time processing and/or reprocessing which is evinced as effectuating ease of use and simplicity in addition to an efficient, effective, functional and integrated capital market equaly and simultaneously accessible to every and all necessarily interested and integral members of the aforementioned UNIVERSAL POPULACE™ to proclaim fill disclosure, enhanced fairness, simultaneous equality, consolidated access, full transparency, best practices and best executions within a capital market of the new millennium. Whereas, hereto it becomes undeniably recognizable that the so-called U.S. SEC always had the legal precedent, vested legal charter and independent governing power and regulatory authority to dictate every and all of the forms, parts, means, segments, manners, methods, processes, technologies and venues to ensure full disclosure, best practices, best executions, enhanced fairness, simultaneous equality, full transparency, consolidated access and perpetual integration from members of the aforementioned UNIVERSAL POPULACE™ which are comprehensively suitable, generally pertinent and broadly useful to every and all aforementioned PUIRLIC FINANCIALS™ statements inclusive of every and all necessarily integrated, critically important and increasingly integral aforementioned PUBLIC FINANCIALS™ instruments for the benefit members of the aforementioned UNIVFRSAL POPULACE™ accessible via necessary innovative developments and technological advancements which were never heretofore available for the so-called U.S. SEC to repossess its independent governing power and regulatory authority within the aforementioned fragmenting capital market inefficiencies in accordance with its vested legal charter. It now more evident that since the legislative enactment, propagation and promulgation of the so-called U.S. Securities Act of 1933 and so-called U.S. Securities Exchange Act of 1934 the technological advancements and innovative developments in software and proprietary operating systems, hardware computing, communications infrastructure and network routing capacities had not yet materialized to the stages of development realized in the previous three decades. As noted the so-called U.S. SEC's nearly a seventy-year period of predominately delegating its vested legal charter and independent governing power and regulatory authority to wrapping, interlacing, coiling, coupling, combining and interlocking techniques, designs, systems, routines, devices, manners, modes, fashions, forms, formats, factors, objects, parts, segments, elements, components, constituents, ingredients, processes, methods and combinations entailing, encompassing, comprising, involving, impacting and/or effecting automatizing real-time holistically steady state synchronized ubiquitous continuum real-time rhombus microprocessing instantaneous transmission and receiver transforming traverse conduit aforementioned UCMOST™ real-time processing and/or reprocessing of every and all public accounting, transport reconciling, independent auditing and financial reporting inclusive of efficient, effective, functional and integrated streamlined, alternating scale, inseparable, seamless and natural wrapping, interlacing, coiling, coupling, combining and interlocking techniques, designs, systems, routines, devices, manners, modes, fashions, forms, formats, factors, objects, parts, segments, elements, components, constituents, ingredients, processes, methods and combinations entailing, encompassing, comprising, involving, impacting and/or effecting automatizing real-time holistically steady state synchronized ubiquitous continuum real-time rhombus microprocessing instantaneous transmission and receiver transforming traverse conduit aforementioned UCMOST™ real-time processing and/or reprocessing of every and all order-entry quotation, matching, clearance, execution, settlement and exchange of insurance, risk financing, credit, cash management and aforementioned PUBLIC FINANCIALS™ instruments this delegation is completely undeniable, unnecessary, undeniable, unnecessary, unwarranted, illogical, unjustifiable, unreasoned and unmitigated, illogical, unjustifiable and unreasoned hereupon. To further understand the so-called U.S. SEC's humble role during nearly seventy-years it is logical to understand that the so-called U.S. SEC's strive and collaborative efforts with self-regulatory professions during this extensive period of time was to establish the principles and standards to measure via generally accepted accounting principles (GAAP); to report via the financial accounting standards board (FASB); and to independently audit via generally accepted auditing standards (GAAS) pertaining to every and all techniques, designs, systems, routines, devices, manners, modes, fashions, forms, formats, factors, objects, parts, segments, elements, components, constituents, ingredients, processes, combined in connection with aforementioned PUBLIC FINANCIALS™ instruments from members of the aforementioned UNIVERSAL POPULACE™, inclusive of their results of operations, and aforementioned PUBLIC FINANCIALS™ instruments transactional exchange initiatives, schemes, ocurrences, happenings, interactions, processes, methods, practices, movements, proceedings, messaging, presentations, notifications, filings, submissions, records, activities, actions, events, endeavors, tasks and affairs. One of the most important amendments to the so-called U.S. Securities Exchange Act of 1934 which enacted the vested legal charter and independent governing power and regulatory authority in the so-called U.S. SEC was the Foreign Corrupt Practices Act of 1977 (FCPA). Of more pertinent interest are comprehensively suitable, generally pertinent and broadly useful to the so-called U.S. SEC's role given the amendment of the so-called U.S. Securities Exchange Act of 1934 was FCPA Part II. FCPA Part II requires senior executives members of the aforementioned UNIVERSAL POPULACE™, whether operating transnationally or not, to generate, process and store detailed records accurately and fairly recording every and all financial transactions in which theirmembers of the aforementioned UNIVERSAL POPULACE™ are involved. FCPA Part II also requires that senior executives members of the aforementioned UNIVERSAL POPULACE™ maintain an adequate system of internal controls such as budgeting, corporate governance, internal auditing, public accounting, transport reconciling, independent auditing and financial reporting. Thus, as it pertains to the so-called U.S. SEC and the aforementioned fragmenting capital market inefficiencies FCPA Part II further ensured that every and all techniques, designs, systems, routines, devices, manners, modes, fashions, forms, formats, factors, objects, parts, segments, elements, components, constituents, ingredients, processes, methods and combinations related to financial transactional initiated by members of the aforementioned UNIVERSAL POPULACE™ necessarily involved the so-called U.S. SEC vested legal charter and independent governing power and regulatory authority over the efficient, effective, functional and integrated streamlined, alternating scale, inseparable, seamless and natural wrapping, interlacing, coiling, coupling, combining and interlocking techniques, designs, systems, routines, devices, manners, modes, fashions, forms, formats, factors, objects, financial reporting and quotation, clearance, executions, settlement and exchange of insurance, risk financing, credit, cash management, investment banking, and PUBLIC FINANCIALS™ instruments transactional activities. It is ironic that so-called U.S. equity and debt derivative oriented instrument options exchanges has historically been pitted against the so-called U.S. equity and debt PUBLIC FINANCIALS™ instruments, and which thereupon subjected to unfair competitive practices from every and all other major so-called U.S. securities exchanges who sought to remove the prohibition of listing futures on individual equities via the 1982 SEC and the Commodities Future Trading Commission (CFTC) accord prohibition agreements. The policy changes that led to the so-called U.S. SEC and CFTC accord inherently developed and continuously propagating and promulgated the aforementioned fragmenting capital market inefficiencies. It is evidentiary documented reference that the so-called U.S. SEC considered this SEC and CFTC 1982 accord a huge mistake in policy making decision processes are comprehensively suitable, generally pertinent and broadly useful to the aforementioned fragmenting capital market inefficiencies because it perpetuates the inefficient, ineffective, dysfunctional and fragmented regulation of products and services related to aforementioned fragmenting capital market inefficiencies in direct contrast to the independent governing power and regulatory authority vested in a single independent entity in most other industrialized and developed sovereign nations from around the world with a vested interest with aforementioned fragmenting capital market inefficiencies. Thereupon, it is here noted that no other independent regulatory system in the world with national UNIVERSAL CAPITAL MARKET™ exchanges segments responsibilities between and among the products and services listed as a function of a single sovereign national UNIVERSAL CAPITAL MARKET™. The so-called U.S. SEC and CFTC 1982 promulgated the aforementioned fragmenting capital market inefficiencies into an extreme anomaly in contrast to other sovereign nations which participate in the W.W. capital markets. Thus, the recent decision by the CFTC to completely resolve these issues of regulation by terminating its existence in a phase out period makes the 1982 accord between and among the so-called U.S. SEC and CFTC a mute point of and which thereupon consolidates every and all governing power and

3. Public Capital Market—Performance History

After more than two-hundred years of sovereign independence the so-called U.S. finds that approximately one hundred million people or nearly fifty percent of so-called U.S. households own some techniques, designs, systems, routines, devices, manners, modes, fashions, forms, formats, factors, objects, parts, segments, elements, components, constituents, ingredients, processes, methods and combinations of currency, time deposit, escrow, trust, individual retirement, defined pension, deferred contribution, social UNIVERSAL CAPITAL MARKET™ security entitlement, insurance policy, insurance contract, mutual fund, stock, bond, option, futures, forward, swap and/or commodity (hereafter collectively “aforementioned PUBLIC FINANCIALS™ instruments”) where aforementioned PUBLIC FINANCIALS™ instruments are retained in every and all multivariate techniques, designs, systems, routines, devices, manners, modes, fashions, forms, formats, factors, objects, parts, segments, elements, components, constituents, ingredients, processes, methods and combinations. These widely recognized so-called U.S. depositor figures are limited in abstract conceptual representation to every and all positions held in derivative forms of currencies, stocks and bonds which are the basic elemental forms of PUBLIC FINANCIALS™ depositors financials instruments ownership. These majority of derivative oriented aforementioned PUBLIC FINANCIALS™ instruments are innately actively and most pervasively passively managed derivative capital pools of transactional exchanges offered to members of the aforementioned UNIVERSAL POPULACE™ premised exclusively on indirect basket oriented techniques, designs, systems, routines, devices, manners, modes, fashions, forms, formats, factors, objects, parts, segments, elements, components, constituents, ingredients, processes, methods and combinations aforementioned PUBLIC FINANCIALS™ instruments, which predominately involved equity and debt PUBLIC FINANCIALS™ instruments, but which, without limitation, go beyond equities and debt aforementioned PUBLIC FINANCIALS™ instruments to include aforementioned PUBLIC FINANCIALS™ instruments which involve derivative positions in an aforementioned PUBLIC FINANCIALS™ instruments inclusive without limitation, of and/or wireless inefficient, portentous and fruitless so-called Internet on aforementioned fragmenting capital market inefficiencies, it is referenced that as of the year-ending 1988 nearly forty-eight million so-called U.S. depositors owned aforementioned PUBLIC FINANCIALS™ instruments in every and all forms, parts, capacities and segments herein referenced, and within the subsequent ten years ending 1998, the estimate figures of so-called U.S. depositors alone doubled to one hundred million. According to a recent PC Computing magazine publication the number of so-called U.S. households that now own aforementioned PUBLIC FINANCIALS™ instruments in techniques, designs, systems, routines, devices, manners, modes, fashions, forms, formats, factors, objects, parts, segments, elements, components, constituents, ingredients, processes, methods and combinations has jumped from +28% in 1989 to 48% in 1999 (PC Computing, February 2000); and according to International Data Corporation (IDC) business-to-business e-commerce which was merely US$30-40 million in 1998 is anticipated to reach US$1.38 trillion by the year-ending 2003. Moreover, the leading industry association of the so-called U.S. SEC industry within the aforementioned fragmenting capital market inefficiencies, the so-called U.S. SEC Industry Association (SIA) in combination with the Transactional exchange Company Institute (ICI) recently polled survey instrument identified only seventy-nine million so-called U.S. depositors as owners aforementioned PUBLIC FINANCIALS™ instruments, albeit it sets forth the industry's own foundation of the figures of so-called U.S. depositors participating in the inefficient, ineffective, dysfunctional and fragmented so-called U.S. market. This 1999 published SIA and ICI financial services and transactional exchange needs research study identified generally and broadly that the percentage growth figures in the number of so-called U.S. depositors has risen +83% since 1983, and former so-called U.S. President William Clinton was quoted as stating the percentage growth figures increased +43% since 1992, the year he was inaugurated into his first term to the Office of the Presidency of the so-called U.S. These aforementioned evidentiary documented reference figures of so-called U.S. depositor participation, directly and/or indirectly within the aforementioned fragmenting capital market inefficiencies are inaccurate, false and misleading in the scope, breadth and depth because most every single legally abiding individual which earns domestic messaging, presentations, notifications, filings, submissions, records, activities, actions, events, endeavors, tasks and affairs performed as so-called U.S. citizen taxpayers's are involuntarily forced to assume contributory deductions to said wages earned to fund social UNIVERSAL CAPITAL MARKET™ security entitlement funds held in trust accounts by the so-called U.S. federal government. The enormous large pools of capital which represent social UNIVERSAL CAPITAL MARKET™ security entitlement funds are by their letter, spirit and nature derivatives of wage earned income currency from so-called U.S. citizen taxpayers's that are converted by the so-called U.S. government into one or more alternative aforementioned PUBLIC FINANCIALS™ instruments albeit these social UNIVERSAL CAPITAL MARKT™ security entitlement funds are usually restricted to debt oriented issues offered by the so-called U.S. government and/or major so-called U.S. members of the aforementioned UNIVERSAL POPULACE™ such as so-called U.S. treasuries, government agency bonds, municipal securities, corporate commercial paper, corporate notes, and corporate bonds. Nevertheless, given the present so-called U.S. political, social, economic and financial environment major reform policies considering these social security entitlements are now being considered which would enable so-called U.S. citizen taxpayers's to manage and thereby deposit a significant portion of their social UNIVERSAL CAPITAL MARKET™ security entitlement funds thereupon ensuring that so-called U.S. citizen taxpayers's assume a greater amount of the aformentioned PUBLIC FINANCIALS™ instruments risk are comprehensively suitable, generally pertinent and broadly useful to their long-term treasure accounting, financial fueling and econometric energizing in an effort to diminish the so-called U.S. government's long-term social UNIVERSAL CAPITAL MARKET™ security entitlement liabilities and ensuring that individuals are capable of capitalizing on the potential upside of the managing their own financial transactional exchanges concerning long-term retirement planning initiatives, schemes, ocurrences, happenings, interactions, processes, methods, practices, movements, proceedings, messaging, presentations, notifications, filings, submissions, records, activities, actions, events, endeavors, tasks and affairs. These findings of fact and evidentiary documented references of knowledge notwithstanding, it is clearly evident that the aforementioned called U.S. households in the early 1980's and in contrast to one in eight adults who owned stock equity aforementioned PUBLIC FINANCIALS™ instruments by 1959. This may be a significant understatement from the findings of fact concerning those so-called U.S. depositors, so-called U.S. citizen taxpayers and wage earners which, directly and indirectly, participate with aforementioned fragmenting capital market inefficiencies via direct holdings in aforementioned PUBLIC FINANCIALS™ instruments financial transactional exchanges instruments or indirectly via monies, currencies, time deposits, escrows, trusts, individual retirements, defined pensions, deferred contributions, social security entitlements, insurance policies, annuity contracts, mutual funds, tracking funds, unit transactional exchange trusts, real estate transactional exchange trusts, closed-end transactional exchanges pools of capital, asset-backed obligations, mortgage-backed obligations, repurchase obligations, collateralized assets, collateralized liabilities, collateralized residual equities, equities, debt, options, futures, forwards, swaps and commodities oriented public PUBLIC FINANCIALS™ depositors financials instruments which represent the heretofore majority of the treasure accounting, financial fueling and econometric energizing members of the aforementioned UNIVERSAL POPULACE™ of the aformentioned PUBLIC FINANCIALS™ instruments from around the world, which is in direct contrast to predictions made in the early 1990's that individual depositors where a disappearing breed. It is logical to acknowledge that premised on the aforementioned every and all real-time processing and/or reprocessing of data and/or information receiver inclusive of the explosion in proprietary software programs, proprietary operating systems, personal-computer hardware manufacture, communications infrastructure and network routing capacities, it may not be to surprising or much of a far-reaching presumption to recognize that these aforementioned so-called U.S. depositor figures and individual global depositor figures may continue to expand exponentially in the coming decades as population growth, ethnic migration, political asylums, and reductions of barriers to entry among national economies continue to shift the population demographics of a single holistically econometric marketplace environment and the volumes of individual persons from around the world who shall come to depend on the performance aforementioned fragmenting capital market themselves, their children and/or their grandchildren to pursue inalienable rights to life, liberty, and happiness via economic and financial prosperity coupled with freedom concerning legal, political, religious, social, economic, financial impositions and/or restrictions forced upon them from tyrant, dictatorship and/or communist driven sovereign nations from around the world. These undeniable and evidentiary findings of fact are premised on a clear understanding of the universal notions of social sciences, ethnic migratory patters, immigration status, naturalization of citizenship, and nationalization of residence may offer a greater perspective on the potential of increasingly exponential growth figures of so-called U.S. depositors, so-called U.S. citizen taxpayers's, wage earners, and/or citizens from every and all other sovereign nations from around the world which inevitably, directly and/or indirectly, participate and which thereupon have a large currency, financial and economic stake with aforementioned fragmenting capital market inefficiencies. Thus, it is also a finding of fact premised on observatory insight and logic that there exist enormous requisite requisite for continued technological innovative developments related to specialty areas aforementioned fragmenting capital market inefficiencies pertaining to the efficient, effective, functional and integrated streamlined, alternating scale, inseparable, seamless and natural wrapping, interlacing, coiling, coupling, combining and interlocking techniques, designs, systems, routines, devices, manners, modes, fashions, forms, formats, factors, objects, parts, segments, elements, components, constituents, ingredients, processes, methods and combinations necessary to offer a resolution to the relevant art comprehensively suitably, generally pertient and broadly useful to meet every and all of the unmet content management, financial service and transactional exchange needs of hundrds of millions of members of the aforementioned UNIVERSAL POPULACE™ whom innately and intrinsically strive to protect, sustain and expand their individual treasure accounting, financial fueling and econometric energizing from the heretofore inefficient, ineffective, dysfunctional and aforementioned fragmenting capital market inefficiencies. In basic review of the clearly aforementioned fragmenting capital market inefficiencies as of the year-ending 2000, Whereas, it is an undeniable and evidentiary findings of fact, documented reference, logical scientific deduction and (DJIA) Composite Index was off from its valuation high attained on Jan. 14, 2000, and the National Association of Securities Dealers Automated Quotation (ASDAQ) Composite Index was off from its valuation high attained on Mar. 10, 2000. This performance review of the year-ending 2000 are comprehensively suitable, generally pertinent and broadly useful to the NYSE-DJIA and the NASDAQ further leads to insight upon which deductive reasoning displays that the NYSE-DJIA erased a significant ten percent of its aforementioned PUBLIC FINANCIALS™ instruments appreciation from its previous year-ending 1999 valuation high, and the NASDAQ erased a significant and substantial portion of its unprecedented eighty-five percent aforementioned PUBLIC FINANCIALS™ instruments appreciation valuation high attained during the year-ending 1999. As of the year-ending 2000 the aforementioned fragmenting capital market inefficiencies displayed in comparison to Dec. 31, 1999 composite index closings the following performance measures: the NASDAQ, S&P 500 and New York Stock Exchange (NYSE) listed Dow Industrials suffered tempestuous exponentially debilitating systematic tempestuous devaluation in the year 2000, leaving their aggregate composite index values with percentage losses of −39.29%, −10.14%, and −6.18%, respectively. Thus, the year-ending 2000 evinced one of the greatest depressions of aforementioned PUBLIC FINANCIALS™ instruments within the U.S. history premised on aforementioned fragmenting capital market inefficiencies, and were directly applicable to the two major, top-tier, prominent, widely-recognized, well-capitalized and traditionally established present licensed securities exchanges, the NYSE-DJIA and the NASDAQ propagating, promulgating and proclaiming the ancient history fragmenting market inefficiencies within the heretofore ancient history fragmented UNIVERSAL CAPITAL MARKET™. As referenced, the NYSE-DJIA and the NASDAQ are the two predominate aforementioned fragmenting capital market inefficiencies incorrectly structured and derived composite indexes which are heretofore considered the two major, top-tier, prominent, widely-recognized, well-capitalized and traditionally established indexes of aforementioned PUBLIC FINANCIALS™ instruments propagating every and all aforementioned fragmenting capital market inefficiencies, and although not clearly evident to the unsophisticated, unknowing, unlettered and unpolished members of the FINANCIALS™ instruments registered with the so-called U.S. Securities and Exchange Commission (SEC) and thereupon listed on one or both of these present licensed physical (NYSE) and electronic (NASDAQ) exchanges within the aforementioned fragmenting capital market inefficiencies. Whereas, it is an undeniable and evidentiary findings of fact, documented reference, logical scientific deduction and intuitive analytical reasoning that with the aforementioned fragmenting capital market inefficiencies during the year-ending 2000 the NASDAQ so-called present composite index realized twice the tempestuous devaluation aforementioned PUBLIC FINANCIALS™ instruments concretizing during the summer and fall months of 1987 which is directly germane to the loss in aforementioned PUBLIC FINANCIALS™ instruments valuation concretizing in 1974 and 1929. The year's of 1974 and 1929 represent the worst events in the history of the tempestuous and exponential increasing systematic volatility within the aforementioned fragmenting capital market inefficiencies in definitive dollar and percentage terminology overshadowed the so-called black monday tempestuous devaluation of aforementioned PUBLIC FINANCIALS™ instruments which occurred and transpired during the summer and fall months of 1987. Whereas, it is an undeniable and evidentiary findings of fact, documented reference, logical scientific deduction and intuitive analytical reasoning that this limited comparison of the tempestuous devaluation aforementioned PUBLIC FINANCIALS™ instruments within the aforementioned fragmenting capital market inefficiencies thus signifies that the year 2000 represented vivid actualization of an unprecedented exponential depression of valuation aforementioned PUBLIC FINANCIALS™ instruments within the aforementioned fragmenting capital market inefficiencies which directly evinced the across-the-board tempestuous devaluation aforementioned PUBLIC FINANCIALS™ instruments within most industrialized, developed and developing nations from around the globe which in their aggregate composite represent part and form of the aforementioned fragmenting capital market inefficiencies. Whereas, it is an undeniable and evidentiary findings of fact, documented reference, logical scientific deduction and intuitive analytical resoning that the largest majority members of the aforementioned UNIVERSAL POPULACE™ inclusive members of the aforementioned UNIVERSAL POPULACE™ from around the information technology present delegate custody, representation, management, administration and quotation, matching, clearance, execution, settlement and transactional exchange aforementioned PUBLIC FINANCIALS™ instruments in every and all multivariate techniques, designs, systems, routines, devices, manners, modes, fashions, forms, formats, factors, objects, parts, segments, elements, components, constituents, ingredients, processes, methods and combinations to professional institutional money managers inclusive of unsophisticated, unknowning, unlettered and unpolished so-called registered commission driven account executives via individual retirement accounts, deferred employed compensation accounts, government endowment entitlement accounts, and other standalone banking, securities and insurance industry ledger balance accounts with any one or a number of the harming, damaging, inuring, insistent, insinuating, imposing, pestilent, impetuous, importune, pestiferous, condescending and insolent enthralling, hindering, entrapping, pretending, miring, fatiguing, maleficience, harassing, engulfing, pressing, malevolent, presuming, imprinting, malicious, suffocating, miring, strangling, repressing, entangling, pestering and oppressing vast network of intermediary members of the aforementioned UNIVERSAL POPULACE™ within the aforementioned fragmenting capital market inefficiencies. The aforementioned PUBLIC FINANCIALS™ instruments which entail, encompass, comprise, involve, impact and/or effect every and all multivariate, multifaceted and multidimensional derivative parts and forms aforementioned PUBLIC FINANCIALS™ instruments represent the largest aspects of the treasure accounting, financial fueling and econometric energizing members of the aforementioned UNIVERSAL POPULACE™ whichever every and all are furthermore undeniably, logically, scientifically and intuitively deduced, apprehended and invoked as necessarily integrated, critically important and increasingly integral members of the aforementioned UNIVERSAL POPULACE™ within the aforementioned fragmenting capital market inefficiencies. Whereas, it is an undeniable and evidentiary findings of fact, documented reference, logical scientific deduction and intuitive analytical resoning that aforementioned PUBLIC FINANCIALS™ instruments are the exclusive multivariate, multifaceted and multidimensional parts and forms utilized to protect, sustain and expand majority of civilized national sovereign borders of every and all of the industrialized, developed and developing nations in the free-market commerce and trade bloc economies from around the world irrespective of whether the members of the aforementioned UNIVERSAL POPULACEM reside and/or operate domestically and/or in foreign territories, or further irrespective of whether these aforementioned PUBLIC FINANCIALS™ instruments originate, are held in custody, represented, managed, administered and/or transacted within domestic and/or foreign territories, and further irrespective of whether professional institutional money managers inclusive of unsophisticated, unknowning, unlettered and unpolished so-called registered commission driven account executives processes the transactional exchange orders on behalf of the uneducated, unsophisticated, unknowning, unlettered and unpolished members of the aforementioned UNIVERSAL POPULACE™ within the aforementioned fragmenting capital market inefficiencies. Whereas, it is an undeniable and evidentiary findings of fact, documented reference, logical scientific deduction and intuitive analytical resoning that the vast network of intermediary harming, damaging, inuring, insistent, insinuating, imposing, pestilent, impetuous, importune, pestiferous, condescending and insolent enthralling, hindering, entrapping, pretending, miring, fatiguing, maleficience, harassing, engulfing, pressing, malevolent, presuming, imprinting, malicious, suffocating, miring, strangling, repressing, entangling, pestering and oppressing vast network of intermediary members of the aforementioned UNIVERSAL POPULACE™ within the aforementioned fragmenting capital market inefficiencies heretofore without invoked within aforementioned UCMOST™ information technology perpetually preclude and prevent members of the aforementioned UNIVERSAL POPULACE™ from receiving full disclosure, best practices, best executions, enhanced fairness, simultaneous equality, full transparency, consolidated access and perpetual integration within an aforementioned efficient UNIVERSAL CAPITAL MARKET™, and furthermore exuberantly-priced, commission driven, and performance incentive oriented professional institutional money managers inclusive of unsophisticated, unknowning, unlettered and unpolished so-called registered commission driven account executives with whom members of the aforementioned UNIVERSAL POPULACE™ heretofore communicate to effectuate notifications, filings, submissions, records, activities, actions, events, endeavors, tasks and affairs are comprehensively imprudent, generally insolent and broadly predatorial when members of the aforementioned UNIVERSAL POPULACE™ seek, pursue and/or request comprehensive, general and broad higher education concerning and regarding every and all multivariate, multifaceted and multidimensional aforementioned PUBLIC FINANCIALS™ instruments into which the large majority of their hard-earned wage income currency dollars are transformed from currency deposits withwith aforementioned fragmenting capital market inefficiencies organizations which undeniably, logically, refereenced, scientifically and intuitively serves as enthralling, engulfing and oppressive barriers to entry to full disclosure, best practices, best executions, enhanced fairness, simulteanoues equality, full transparency, consolidated access and perpetual integration within the aforementioned fragmenting capital market inefficiencies. The heretofore major, top-tier, prominent, well-capitalized, well-established and traditional vast networks of intermediary aforementioned PUBLIC FINANCIALS™ organizations and professional institutional money managers inclusive of unsophisticated, unknowning, unlettered and unpolished so-called registered commission driven account executives heretofore represent every and all techniques, designs, systems, routines, devices, manners, modes, fashions, forms, formats, factors, objects, parts, segments, elements, components, constituents, ingredients, processes, methods and combinations available to enable tens of hundreds of thousands members of the aforementioned UNIVERSAL POPULACE™ and hundreds of millions members of the aforementioned UNIVERSAL POPULACE™ from around the world to inefficiently, ineffectively, dysfunctional and in fragmented part and form access every and all of the tens of thousands aforementioned PUBLIC FINANCIALS™ instruments registered, listed and exchanged within the aforementioned fragmenting capital market inefficiencies within a necessarily integrated, critically important and increasingly integral aforementioned efficient UNIVERSAL ECONOMY™. Whereas, it is an undeniable and evidentiary findings of fact, documented reference, logical scientific deduction and intuitive analytical resoning that irrespective of whether these large pools of deposited capital owned exclusively by members of the aforementioned UNIVERSAL fashions, forms, formats, factors, objects, parts, segments, elements, components, constituents, ingredients, processes, methods and combinations of aformentioned PUBLIC FINANCIALS™ instruments are held in custody, represented, managed, administered and/or transacted within the aforementioned fragmenting capital market inefficiencies via heretofore major, top-tier, prominent, well-capitalized, well-established and traditional vast networks of intermediary aforementioned PUBLIC FINANCIALS™ organizations and professional institutional money managers inclusive of unsophisticated, unknowning, unlettered and unpolished so-called registered commission driven account executives and transacted heretofore via licensed physical and/or electronic exchanges within domestic and/or foreign territoties. Furthermore, this undeniable and evientiary finding of fact, documented reference, logical scientific deduction and intuitive analytical reasoning simply evinces and represents to obvious ethralling, engulfing and oppressive barriers to entry concerning and regarding full disclosure, best practices, best executions, enhanced fairness, simulteanoues equality, full transparency, consolidated access and perpetual integration necessarily heretofore demanded by members of the aforementioned UNIVERSAL POPULACE™ within the aforementioned fragmenting capital market inefficiencies. Moreover, this undeniable and evientiary finding of fact, documented reference, logical scientific deduction and intuitive analytical reasoning does not diminish the fact that tens of hundreds of thousands of the uneducated, unsophisticated, unknowning, unlettered and unpolished members of the aforementioned UNIVERSAL POPULACE™ and hundreds of millions of the uneducated, unsophisticated, unknowning, unlettered and unpolished members of the aforementioned UNIVERSAL POPULACE™ necessarily deposit their legal, political, social, economic and financial resources in every and all heretofore available techniques, designs, systems, routines, devices, manners, modes, fashions, forms, formats, factors, objects, parts, segments, elements, components, constituents, ingredients, processes, methods and combinations and are subsequently transformed into aforementioned PUBLIC FINANCIALS™ instruments withwith aforementioned fragmenting capital market inefficiencies. It is an undeniable and evientiary finding of fact, documented reference, logical scientific deduction and intuitive analytical reasoning that most civilized members of the deposit their wage income earning currency dollars and subsequently transform the largest majority of their literal numerical dollar figures into aforementioned PUBLIC FINANCIALS™ instruments to protect, sustain and expand their respective treasure accounting, financial fueling and econometric energizing in a highly dynamic and inherently volatile, fragile, frigid and ruthless global marketplace economy, wherefrom hereto undeniably, logically, scientifically and intuitively hold the largest stake in the future aforementioned fragmenting capital market inefficiencies and in derivative fashion severely enthralled, engulfed and oppressed by the heretofore major, top-tier, prominent, well-capitalized, well-established and traditional vast networks of intermediary aforementioned PUBLIC FINANCIALS™ organizations and professional institutional money managers inclusive of unsophisticated, unknowning, unlettered and unpolished so-called registered commission driven account executives which inherently propagating and promulgate aforementioned fragmenting capital market inefficiencies via communications further broadcast, distributed and syndicated via conceptual aids within a single holistically econometric marketplace environment. A brief analytical albeit comprehensive review of the value of capitalization within the aforementioned fragmenting capital market inefficiencies inclusive of its benchmark performance measures it is important to understand the astonishing appreciations and/or depressions of valuations aforementioned PUBLIC FINANCIALS™ instruments over the course of the last thirty-two years. It is referenced that as of 1969 the world's total value of basic aforementioned PUBLIC FINANCIALS™ instruments which typically include currency, stock equity and bond debt aforementioned PUBLIC FINANCIALS™ instruments was merely US$2 trillion and this figure appreciated to approximately US$22 trillion by the year ending 1990. During that time period alone it is referenced that the stock equity aforementioned PUBLIC FINANCIALS™ instruments soared from US$300 billion in market capitalization around the world to approximately US$5.5 trillion. Since the beginning of the 1990's the composite aggregate of the UNIVERSAL CAPITAL MARKET™ valuation of every and all directly aforementioned PUBLIC FINANCIALS™ instruments listed on these the NYSE and the NASDAQ was approximately US$30 trillion. This combined aggregate composite stock equity aforementioned PUBLIC FINANCIALS™ instruments listed as domestic or bank intermediary foreign issued ADR's participating within the aforementioned fragmenting capital market inefficiencies within the last five years, and the Federal Reserve Central Bank of the United States recently reported that it believes there is approximately US$40-45 trillion inaforementioned PUBLIC FINANCIALS™ instruments on the balance sheet accounts of the so-called United States of America. Clearly the astronomic appreciative valuations concretizing with aforementioned fragmenting capital market inefficiencies within the last thirty years alone contrast with the fundamental historical notions of prudent and risk managed UNIVERSAL CAPITAL MARKET™ valuations, and furthermore disturbingly is the fact that as more members of the aforementioned UNIVERSAL POPULACE™ become fascinated with the illusionary notion of a ride-the-tide scheme to solving every and all of their present and prospective economic and financial dilemmas inherent to modem day living in civilized societies innovative and technologically panacean cutting-edge innovative developments and technological advancements become ever more important to prevent the systemic tempestuous exponentially detrimental implications of systematic volatility and increases in the costs of capital with aforementioned fragmenting capital market inefficiencies. Whereas, it is an undeniable and evidentiary findings of fact, documented reference, logical scientific deduction and intuitive analytical reasoning that within an article published in the business section of the Miami Herald dated Mar. 10, 2001, it was reported that in less than a twelve month period of time one of a single holistically econometric marketplace environment's major and top-tier, extremely prominent and well-established present licensed so-called U.S. securities exchange, the NASDAQ, which also as an evidentiary findings of fact and documented reference is one of a single holistically econometric marketplace environment's leading marketplaces for aforementioned PUBLIC FINANCIALS™ instruments transactional exchange initiatives, schemes, ocurrences, happenings, interactions, processes, methods, practices, movements, proceedings, messaging, presentations, notifications, filings, submissions, records, activities, actions, events, endeavors, tasks and affairs, alone displayed sub-par performance which concretizing systematic volatility in stock equity aforementioned PUBLIC from its high level valuation achieved in the year 2000. Furthermore, clear and apparent evidence that the exponential twelve-month devalution of the NASDAQ during the year-ending 1999 is not alone in suffering tempestuous devaluation in PUBLIC FINANCIALS™ instruments, which exposes the tempestuous exponentially detrimental increases in exponential systematic volatility with aforementioned fragmenting capital market inefficiencies, an article published in the business section of the Miami Herald dated Mar. 17, 2001, reported that as of the week-ending Mar. 16, 20001, the other present world-leading major and top-tier, extremely prominent and well-established present licensed so-called U.S. securities exchange meter, the NYSE-DJIA, evinced a week-ending −821.21 point loss or conversely a −7.7% tempestuous devaluation inaforementioned PUBLIC FINANCIALS™ instruments which, via a major, top-tier, widely recognized and well-established public organization which monitors a more appropriate broad-based meter of small, medium and large market capitalizations within the aforementioned fragmenting capital market inefficiencies evidently members of the aforementioned UNIVERSAL POPULACE™ suffered via week-ending tempestuous devalution of approximately -US$772 billion, comparatively the worst point and percentage loss suffered by members of the aforementioned UNIVERSAL POPULACE™ in more than eleven years dating back to 1990, and for the week overshadowed the tempestuous −805.71 point loss suffered as of the week-ending Apr. 14, 2000. Whereas, it is an undeniable and evidentiary findings of fact, documented reference, logical scientific deduction and intuitive analytical reasoning that tempestuous exponentially detrimental exponential increases in systematic volatility present engulf, enthrall and oppress aforementioned fragmenting capital market inefficiencies, wherein the article published in the business section of the Miami Herald dated Mar. 17, 2001, reported that as of the week-ending Mar. 16, 20001, the ancient history NYSE-DJIA a uneqivocally narrow and emphatically insolent meter of the so-called U.S. economy comprised of the so-called blue-chipmembers of the aforementioned UNIVERSAL POPULACE™ whose aforementioned PUBLIC FINANCIALS™ instruments are registered, listed and exchanged respectively by members of the aforementioned UNIVERSAL POPULACE™, and whom display market capitalizations, which represent instruments outstanding in the marketplace multiplied by the capital market valuation of those PUBLIC FINANCIALS™ instruments, wherefrom these market capitalizations are normaly in excess of US$10 billion, for the week-ending Mar. 16, 2001 suffered a tempestuous −16.2% devaluation from its 11,722.98 high valuation composite index point level attained on Jan. 14, 2000 and as of the printing of the aforementioned article resides at a 9,823.41 composite index point level, wherein moreover the ancient history NASDAQ suffered a tempestuous 62.5% devalution from its 5,048.62 high valuation composite index point level attained on Mar. 10, 2000 and as of the printing of the aforementioned article resides at a 1,890.91 composite index point level, and furthermore the ancient history Standard and Poor's (S&P) a logically more appropriate and suitable meter of the largest five hundred members of the aforementioned UNIVERSAL POPULACE™ within the aforementioned fragmenting capital market inefficiencies has suffered a tempestuous −25% devaluation from its 1,527.46 high valuation composite index point level attained during the year-ending 2000 and as of the printing of the aforementioned article resides at a 1,150.53 composite index point level. Whereas, it is an undeniable and evidentiary findings of fact, documented reference, logical scientific deduction and intuitive analytical reasoning that an article published in the business section of the Miami Herald dated Mar. 25, 2001, reported that the ancient history Willshire 5000 so-called Total Market Composite Index which is deemed to be a broader market indice in contrast to the NYSE-DJIA, NASDAQ and the S&P has also suffered a tempestuous −29% devaluation from its 14,751.64 high valuation composite index point level attained on March 24 during the year-ending 2000 and as of the printing of the aforementioned article resides at a 10,475.38 composite index point level inclusive of the findings that the largest mutual funds of the heretofore major, extremely prominent, well-established and ancient history mutual funds within the aforementioned fragmenting capital market inefficiencies have also logically, as derivative pools aforementioned PUBLIC FINANCIALS™ instruments from members of the aforementioned UNIVERSAL POPULACE™, suffered temptestuous devalutions ranging from −14% to −30% thus far in the year 2001, within the predominately deferred compensation retirement accounts of the members of the aforementioned UNIVERSAL comprehensive unequivocal absolute resolution actualizing innovative information technology invoked within aforementioned UCMOST™ information technology wherefrom are hereto discovered comprehensively suitable, generally pertinent and broadly useful to completely resolve every and all of the aforementioned fragmenting capital market inefficiencies inclusive of, without limitation actualizaing new combinatorial terminological denominate code to eradicate the inefficient, ineffective, imprudent, unsuitable, unlettered, ignorant, uneducated and unpolished ancient history terminological denominate of so-called bear markets, so-called bull markets, and so-called Wall Street to inapporiately categorize, classify and catalog any and all respective appreciation and depression aforementioned PUBLIC FINANCIALS™ instruments inclusive of, without limitation, propagating every and all misconstrued, inappropriate, insolent, derogatory, meaningless, misleading and condesending preconceived notions of the how and why transactional exchange initiatives, schemes, ocurrences, happenings, interactions, processes, methods, practices, movements, proceedings, messaging, presentations, notifications, filings, submissions, records, activities, actions, events, endeavors, tasks and affairs are realized withwithin a capital market and thereof from where every and all comprehensively suitable, generally pertinent and comprehensively suitable aforementioned PUBLIC FINANCIALS™ statements are derived in a highly dynamic and inherently volatile, fragile, frigid and ruthless heretofore capital market which intrinsically and integrally transcends every and all, without limitatoin, of the national sovereign industrialized, developed and developing free-market economic and trade bloc economies within, throughout and transceding the global marketplace ennvironment. As if this was not enough evidence of the tempestuous exponentially detrimental exponential increases in systematic volatility which undeniably, respectively, independently, autonomously, evidently, undeniably, logically, scientifically and intuitively derives tempestuous exponentially debilitating exponential increases in cost of capital via propagating, promulgating and proclaiming aforementioned fragmenting capital market inefficiencies, it is clearly an undeniable and evidentiary findings of fact, documented reference, logical scientific deduction and intuitive analytical reasoning that nothing more than outright panic driven selling frenzies within every and all industries scientific and intuitive culprit of this concretizing tempestuous exponentially detrimental and tempestuous exponentially debilitating turbulent situation, and via the time-lagged every and all real-time processing and/or reprocessing of data and/or information receiver of so-called U.S. economic transactions is undeniable, unnecessary, unwarranted, illogical, unjustifiable, unreasoned and unmitigated, undeniable, unnecessary, undeniable, unnecessary, unwarranted, illogical, unjustifiable, unreasoned and unmitigated, illogical, unjustifiable and unreasoned, unjustifiable and the largest high-technology software and operating systems development, hardware and semi-conductor computing manufacturers, wire jack lines, wire-less and artificial satellite communicative carriers and computing network infrastructure product and serive providers of a single holistically econometric marketplace environment have been subjugated and subjected to having suffered, been injured and financially harmed as evinced via their aforementioned PUBLIC FINANCIALS™ instruments via year-ending 2000 respective tempestuous devaluations among the largest and most respected high-technology aforementioned PUBLIC FINANCIALS™ instruments from members of the aforementioned UNIVERSAL POPULACE™ have also suffered via actualization of an approximate industry aggregate composite tempestuous devaluation of approximately −40% as evinced within an article published in the business section of the Miami Herald dated Feb. 11, 2001. To further describe and explain this undeniable and evidentiary findings of fact, documented reference, logical scientific deduction and intuitive analytical reasoning, an article published in the business section of the Miami Herald dated Mar. 17, 2001, reported that panic driven selling frenzy evinced as of the week-ending Mar. 16, 2001 has ironically and inappropriately enhanced focus of attention on the so-called U.S. Federal Reserve Board of Governors, so-called U.S. Federal Open Market Committee and so-called U.S. Federal Reserve Bank wherein unsuitably the interest surrounds what speculative manipulation it may enact premised on altering, changing and adjusting the Federal Funds Rate within the coming week as the so-called measure of ensuring the so-called U.S. economy does not enter a recession. The undeniably and evidently ironic, inappropriate, unsuitable and speculative expected alteration, change and adjustment widely anticipated by members of the aforementioned UNIVERSAL POPULACE™ in information receiver comprehensively suitable, generally pertinent and broadly useful to the sustenance, stability, productivity, growth and expansion of the present so-called U.S. economy sheds tremendous amounts and enormous light on the specious findings, references logical deductions and misconstrued analytical reasoning that so-called U.S. Federal Reserve Board of Governors, so-called U.S. Federal Open Market Committee and so-called U.S. Federal Reserve Bank inclusive members of the aforementioned UNIVERSAL POPULACE™ whichever every and all are furthermore undeniably, logically, scientifically and intuitively deduced, apprehended and invoked as necessarily integrated, critically important and increasingly integral members of the aforementioned UNIVERSAL POPULACE™ premised on the realities of the present economic situation. Therefrom, the article published in the business section of the Miami Herald dated Mar. 17, 2001, reported that the so-called leading albeit logically time-lagged during the month of February 2001 evinced industrial production is in line with historial norms and a widely recognized university meter of consumer confidence evinced increases therein, while national employment and so-called monetayr inflation meters evince levels at or near the lowest ranges in the history of the so-called U.S. economy. In a complete one-hundred and eighty degree retreat from recent speculative alterations, changes and adjustments by the so-called U.S. Federal Reserve Board of Governors, so-called U.S. Federal Open Market Committee and so-called U.S. Federal Reserve Bank with less than a twelve month period of time, it is apparently considering altering, changing and adjusting the Federal Funds Rate from its present recent increases up to a +5.5% rate level to figures which evince a potential three-quarter of a percentage retreat and speculation is widely recongized and documented to reference that the so-called U.S. Federal Reserve Board of Governors, so-called U.S. Federal Open Market Committee and so-called U.S. Federal Reserve Bank may be ponder a level of +4.5% in one swift, albeit undeniably and evidently ironic, inappropriate, unsuitable and speculative and manipulateve alteration, change and adjustment. Within an article published in the business section of the Miami Herald dated Mar. 21, 2001, it was reported that the so-called U.S. Federal Reserve Board of Governors, so-called U.S. Federal Open Market Committee and so-called U.S. Federal Reserve Bank effectuated an alteration, change inefficiencies realized a −238.35 composite index point level tempestuous devaluation in the ancient history NYSE-DJIA composite index and as of the printing of the aforementioned article resides at 9,720.76 composite index point level, the ancient history NASDAQ composite index realized a −93.74 composite index point level tempestuous devaluation and as of the printing of the aforementioned article resides at a 1,857.44 composite index point level, and the ancient history S&P composite index realized a 28.19 composite index point level devalution and as of the printing of the aforementioned article resides at 1,142.62 composite index point level, wherefrom furthermore within an article published in the business section of the Miami Herald dated Mar. 22, 2001, aforementioned fragmenting capital market inefficiencies realized a -233.76 composite index point level tempestuous devaluation in the ancient history NYSE-DJIA composite index and as of the printing of the aforementioned article resides at 9,487.01 composite index point level, the ancient history NASDAQ composite index realized a −27.21 composite index devaluation and as of the printing of the aforementioned article resides at a 1,830.23 composite index point level, and the ancient history Standard & Poor's realized a −20.48 composite point level devalution and as of the printing of the aforementioned article resides at 1,122.14 composite index point level, thus actualizing further aggregate tempestuous devaluation aforementioned PUBLIC FINANCIALS™ instruments across the industries and sectors which transcend the national sovereign borders of every and all of the industrialized, developed and developing free-market commerce and trade bloc economies thoughout a single holistically econometric marketplace environment. In the respective articles published in the business section of the Miami Herald dated Mar. 21, 2001, and Mar. 22, 2001, it was reported that many speculate the disappointment in the so-called U.S. Federal Reserve Board of Governors, so-called U.S. Federal Open Market Committee and so-called U.S. Federal Reserve Bank not reducing the so-called Federal Funds Rate interest rate by −0.75% in combination with speculation about the antiquated, archaic, ancient history and superannuated so-called Consumer Price Index (CPI) are perceived as culpable for the continued evidentiary tempestuous exponentially detrimental increases in systematic volatility and tempestuous exponentially debilitating increases in the costs of capital, wherefrom evidence to supplant every and all inefficient, suffocating, strangling, entangling, oppressing, repressing, lawless, unnecessary, unwarranted, unjustifiable, antiquated, archaic, ancient history preconceived notions that the so-called U.S. Federal Reserve Board of Governors, so-called U.S. Federal Open Market Committee and so-called U.S. Federal Reserve Bank is authorized to alter, change and adjust the so-called long-term monetary policy of the so-called U.S. via inducing arbitrary manipulation of so-called Federal Funds Rate under veiled guise of so-called monetary policies and/or so-called economic policies which involve unsupported, unnecessary, unwarranted, illogical, unjustifiable, unreasoned, unmitigated, unncessary and unjustifiable commentary, remarks, insinuations and/or actions heretofore comprehensively imprudent albeit generally pertinent and broadly applicable to inefficient, ineffective, antiquated, archaic, ancient history and superannuated so-called theory of the law of large number inductive inferences derived from inefficient, ineffective, antiquated, archaic, ancient history polling statistics from the so-called Consumer Price Index (CPI) time-lagged and dated survey instruments; inclusive of inducement of arbitrary manipulation of so-called Federal Funds Rate under veiled guise of so-called monetary policies and/or so-called economic policies which involve unsupported, unnecessary, unwarranted, illogical, unjustifiable, unreasoned, unmitigated, unncessary and unjustifiable commentary, remarks, insinuations and/or actions heretofore comprehensively imprudent albeit generally pertinent and broadly applicable to inefficient, ineffective, antiquated, archaic, ancient history and superannuated so-called theory of the law of large number inductive inferences derived from inefficient, ineffective, antiquated, archaic, ancient history polling statistics from the so-called National Association of Purchasing Managers (NAPM) time-lagged and dated survey instruments; inclusive of inducement of arbitrary manipulation of so-called Federal Funds Rate under veiled guise of so-called monetary policies and/or so-called economic policies which involve unsupported, unnecessary, unwarranted, illogical, unjustifiable, unreasoned, unmitigated, unncessary and unjustifiable commentary, remarks, insinuations and/or actions heretofore comprehensively imprudent albeit generally pertinent and broadly applicable to inefficient, ineffective, antiquated, archaic, ancient history and superannuated so-called Department of Labor time-lagged and dated Unemployment Announcements (LABOR). In comprehensive review of the arbitrary manipulation of so-called Federal Funds Rate by the quai-private under veiled and misconstrued preconceived notions of so-called independence from the so-called U.S. Federal Reserve Board of Governors, so-called U.S. Federal Open Market Committee and so-called U.S. Federal Reserve Bank, further under veiled guise of so-called monetary policies and/or so-called economic policies which involve unsupported, unnecessary, unwarranted, illogical, unjustifiable, unreasoned, unmitigated, unncessary and unjustifiable commentary, remarks, insinuations and/or actions heretofore comprehensively imprudent albeit generally pertinent and broadly applicable to inefficient, ineffective, antiquated, archaic, ancient history and superannuated so-called theory of the law of large number inductive inferences derived from inefficient, ineffective, antiquated, archaic, ancient history polling statistics, it is reported within a front-page article in the Miami Herald, data Apr. 19, 2001, that the so-called U.S. Federal Reserve Board of Governors, so-called U.S. Federal Open Market Committee and so-called U.S. Federal Reserve Bank have arbitrary effectuated manipulations, changes and/or alterations to so-called Federal Funds Rate under veiled guise of so-called monetary policies and/or so-called economic policies which involve unsupported, unnecessary, unwarranted, illogical, unjustifiable, unreasoned, unmitigated, unncessary and unjustifiable commentary, remarks, insinuations and/or actions entailing, encompassing, comprising, involving, impacting and effecting a single holistically econometric marketplace environment over the course of the heretofore twenty four months on the following dates as of Jun. 29, 1999, when the so-called Federal Funds Rate point level was below +5.0%: Jun. 30, 1999, +5.0%; Aug. 24, 1999, +0.25% to 5.25%; Nov. 16, 1999, +0.25% to 5.5%; Feb. 2, 2000, +0.25% to 5.75%; Mar. 21, 2000, +0.25% to +6.0%; May 16, 2000, +0.5% to +6.5%; Jan. 3, 2001, −0.5% to +6.0%; Jan. 31, 2001, −0.5% to +5.5%; Mar. 20, 2001, −0.5% to +5.0%; Apr., 18, 2001, −0.5% to +4.5%. Whereas, it is an undeniable and evidentiary findings of fact, documented reference, logical scientific deduction and intuitive analytical reasoning that the so-called U.S. Federal Reserve Board of Governors, so-called U.S. Federal Open Market Committee and so-called U.S. the so-called Federal Funds Rate, premised on specious and speculative beliefs of increases in so-called inflation fears and slowdown in econometric activities, under the guise preconception that central heretofore so-called banks are a so-called safety net within a capital market; whereas, effectively raising the heretofore so-called cost of capital within the capital market to levels never before seen in history, whereby generating a tempestuous debilitating and horrifically detrimental rise in the so-called real interest rate to levels never before evinced in the capital market essentially arbitrarily skyrocketting borrowing costs of members of the aforementioned UNIVERSAL POPULACE™; whence, undeniably, logically, technically, scientifically and intuitively triggering a debilitating wide-spread meltdown and detrimental catagious wild-fire spreading of obscurant fear, uncertainty, volatility and lack of hope in the sustenance of econometric transactional activities in a capital market, whereof during 1995, it became readily obvious and apparent that at year-end 1994 so-called inflation evinced historically low levels and evinced an aggregate increase of +2.7% during a year in which tens of billions of so-called dollars in market valuation were eradicated from the capital market on a world-wide scale. Whereas, it is reported within the article published in the front-page of the Miami Herald, dated Apr. 19, 2001, that among the obscure, obfuscating, veiled and/or opaque cited reasoning for the so-called chairman to requisite, albeit with a concurring vote approval, the so-called U.S. Federal Reserve Board of Governors, so-called U.S. Federal Open Market Committee and so-called U.S. Federal Reserve Bank effectuating the Apr. 18, 2001, manipulation, change and/or alteration, which undeniably, logically, scientifically and intuitively effectively subsidizes the antiquated, archaic, ancient history and superannuated U.S. banking system, was all of the following: so-called weak business spending; so-called reduction in household wealth due to falling prices of aforementioned PUBLIC FINANCIALS™ instruments; so-called perceived global economic slowdown; so-called lower consumer price index polling numbers of so-called inflation; so-called lower corporate investment in new equipment; so-called declining corporate profits; so-called declining consumer confidence; so-called slower global econometric growth. Furthermore, it is reported within an article published in the business section of Miami Herald, dated Apr. 20, 2001, that the so-called vice-chairman economists' group on central bank so-called secrecy, apparently was outspoken subsequent to the Apr. 18, 2001, manipulation, change and/or alteration to the so-called Federal Funds Rate, stating effectively that the so-called U.S. Federal Reserve Board of Governors, so-called U.S. Federal Open Market Committee and so-called U.S. Federal Reserve Bank believes it is too soon to say that the so-called sagging economy has bottomed out, but that it is remaining vigilant in its so-called work to prevent a recession, while referencing that the so-called U.S. Federal Reserve Board of Governors, so-called U.S. Federal Open Market Committee and so-called U.S. Federal Reserve Bank was uneasy about the so-called outlook for business investment spending because they speculate that so-called companies are being so-called squeezed by so-called declining profits and so-called falling prices of aforementioned PUBLIC FINANCIALS™ instruments. Whereas, it is an undeniable and evidentiary findings of fact, documented reference, logical scientific deduction and intutive analytical reasoning that there is no substantive logical and/or justifiable reasoning for the so-called U.S. Federal Reserve Board of Governors, so-called U.S. Federal Open Market Committee and so-called U.S. Federal Reserve Bank to speculate as to whether or not there is a so-called increase and/or decline in global econometric developmental growth, and therefrom evidently and arbitrarily manipulate, change and/or alter the direction and/or course of interest rates, valuations and/or transactional exchanges involving the sovereign national industrialized, developed and developing free-market commerce and trade block economies within, throughout and transcending a single holistically econometric marketplace environment; while furthermore there is no substantive logical and/or justifiable reasoning for the so-called U.S. Federal Reserve Board of Governors, so-called U.S. Federal Open Market Committee and so-called U.S. Federal Reserve Bank to speculate as to whether their obscure, obfuscating, veiled and/or opaque preconceived notions of so-called outlook for business investment spending, due to the fact that so-called companies are being so-called squeezed by so-called declining profits and so-called falling prices of aforementioned PUBLIC FINANCIALS™ instruments, and therefrom evidently and arbitrarily manipulate, change and/or alter the direction and/or course of interest rates, valuations and/or transactional exchanges involving the sovereign national industrialized, while moreover there is no substantive logical and/or justifiable reasoning for for the so-called U.S. Federal Reserve Board of Governors, so-called U.S. Federal Open Market Committee and so-called U.S. Federal Reserve Bank to speculate as to whether their obscure, obfuscating, veiled and/or opaque preconceived notions of so-called declining consumer confidence premised on time-lagged and dated CPI polling statistical surveys, inclusive of so-called declining corporate investment spending premised on time-lagged and dated NAPM polling statistica surveys, and/or so-called increasing and/or declining inflation premised on U.S. Departmt ent Labor time-lagged and dated unemployment polling statistical surveys, and therefrom arbitrarily believe they are legally entitled to manipulate, change and/or alter the price valuations of aforementioned PUBLIC FINANCIALS™ instruments to prevent further eroding of personal and/or corporate wealth and so-called work to prevent a U.S. and/or global recession. Whereas, it is an undeniable and evidentiary findings of fact, documented reference, logical scientific deduction and intutive analytical reasoning that traversing the national sovereign industrialized, developed and developing free-market commerce and trade bloc economies of a single holistically econometric marketplace environment driven exclusively by a single holistically econometric marketplace environment, retrenchments and/or expansions of capital depositing and/or capital investing are natural initiatives, schemes, ocurrences, happenings, interactions, processes, methods, practices, movements, proceedings, messaging, presentations, notifications, filings, submissions, records, activities, actions, events, endeavors, tasks and affairs involving factual real-time transactional exchanges among members of the aforementioned PUBLIC FINANCIALS™ organizations inclusive of, without limitation, factual real-time transactional exchanges among individual members of the aforementioned UNIVERSAL POPULACE™ and no one person and/or legal entity residing and/or operating, anywhere, anyplace and/or anytime in the history of the formalized societal civilization has ever had any legal, justifiable, warranted, evidentiary, logical, scientific, and/or intuitive rights whatsoever to predetermine the valuations of aforementioned PUBLIC FINANCIALS™ instruments withwithin a capital market, inclusive of so-called growths, developments, retrenchments and/or expansions within, throughout and/or transcending a market is contrary to the undeniable, evidentiary, logical, scientific and intutive principles of finance which must be learned by every and all members of a capital market living human organisms and/or legal existent organizations must understand they instrinsically exhibit an inordinately self-fish and extreme propensity for more currency money rather than less currency money; living human organisms and/or legal existent organizations must understand they should intrinsically be willing to invest excess currency money at any given period of time in exchange for future cash flow streams inclusive of a return of principal tommorow; living human organisms and/or legal existent organizations must understand that that intrinsically past performance and/or intrinsically historical stability withwithin a capital market is no guarantee, warranty and/or predication of intrinsic future performance and/or intrinsic future stability; while undeniably, evidently, logically, scientifically and intuitively of greatest importance related and/or concerning the long-term treasure accounting, financial fueling and econometric energizing of tens of hundreds of millions of individual members of the aforementioned UNIVERSAL POPULACE™, living human organisms and/or legal existent organizations must learn that a capital market is inherently volatile, dynamic, fragile, frigid and ruthless environment, wherefrom heretofore and hereafter nothing is gained if nothing is risked, wherence there is innately and intrinsically risk involved in pursuing, hoping for and/or wishing for a return on a principal sum of currency denominated money; wherefrom thereupon no one person and/or legal entity residing and/or operating, anywhere, anyplace and/or anytime has any legal, justifiable, warranted, evidentiary, logical, scientific, and/or intuitive rights whatsoever to predetermine the valuations of aforementioned PUBLIC FINANCIALS™ instruments withwithin a capital market, wherefrom to stipulate otherwise and/or anything to the contrary is completely ludricrous and unequivocally undermines the entire foundation upon which a capital market belonging to every and all members of the aforemenioned UNIVERSAL POPULACE™ existent, participating, residing and/or operating anywhere, anytime and/or anyplace related to the national sovereign industrialized, developed and developing free-market commerce and trade bloc economies within, throughout and transcending a single holistically econometric marketplace environment: undeniably, theoretically, deduction and intutive analytical reasoning that every and all of the above mentioned speculations premised on obscure, obfuscating, veiled and/or opaque preconceived notions and antiquated, archaic, ancient history and superannuated heretofore manipulations, changes and/or alterations to the price valuations of aforementioned PUBLIC FINANCIALS™ instruments, under guise of so-called monetary policies and/or so-called economic policies, by the so-called U.S. Federal Reserve Board of Governors, so-called U.S. Federal Open Market Committee and so-called U.S. Federal Reserve Bank are portentous, pretentious, specious, and potentially extremely negligent, fraudulent and/or illegal, wherefrrom evidently and logically exponentially exacerbating irrational exuberance of uncertainties and speculations among individual members of the aforementioned UNIVERSAL POPULACE™. Furthermore, every and all such misconstrued, portentous, pretentous, inefficient, antiquated, archaic, ancient history and superannuated heretofore preconceived notions from the heretofore so-called U.S. Federal Reserve Board of Governors, so-called U.S. Federal Open Market Committee and so-called U.S. Federal Reserve Bank, undeniably, evidently, logically, scientifically and intuitively create, propagate and/or promulgate unnecessary, unwarranted and unjustified tempestuous increases in systematic volatility of aforementioned PUBLIC FINANCIALS™ instruments within, throughout and transcending a single holistically econometric marketplace environment, while concurrently creating, propagating and/or promulgating unnecessary, unwarranted and unjustified tempestuous increases in the cost of capital of members of the aforementioned UNIVERSAL POPULACE™. Whereas, it is an undeniable and evidentiary findings of fact, documented reasoning, logical scientific deduction and intuitive analytical reasoning that there are vast numbers Of antiquated, archaic, ancient history, unlettered, ignorant, unschooled, unseen and unknowing preconceived notions believed by the so-called U.S. Federal Reserve Board of Governors, so-called U.S. Federal Open Market Committee and so-called U.S. Federal Reserve Bank concerning the role and function of a capital market, and they intrinsically cause detrimental and debilitating irreparable harm to treasure accounting, financial fueling and econometric energizing of every all of the tens of hundreds of millions of individual members of the aforementioned UNIVERSAL POPULACE™ existent, participating, economies within, throughout and transcending a single holistically econometric marketplace environment, to allow the aforementioned to persist is insolent, feculent, feckless, imprudent and hereto knowingly reckless. Whereas, it is an undeniable and evidentiary findings of fact, documented reference, logical scientific deduction and intuitive analytical reasoning that every and all arbitrary manipulation, changing and altering decisions from the inefficient, suffocating, strangling, entangling, oppressing, repressing, lawless, unnecessary, unwarranted, unjustifiable, antiquated, archaic, ancient history preconceived notions that the so-called U.S. Federal Reserve Board of Governors, so-called U.S. Federal Open Market Committee and so-called U.S. Federal Reserve Bank under veiled guise of so-called monetary policies and/or so-called economic policies, invoke tempestuous devaluation aforementioned PUBLIC FINANCIALS™ instruments inclusive of tempetuous increases in the cost of capital of members of the aforementioned UNIVERSAL POPULACES™: promoting, distributing, propagating and promulgating, via communications media conduits of every and all conceptual aids, to purpot, tout, bolster, aggradandize, propagandize and disseminate arbitrary decisions utilizing every and all ancient history aforementioned fragementing market inefficiencies all of which respectively and in comprehensive fashion are unlettered, ignorant, uneducated and unpolished preconceived notions and misconstrued beliefs premised exclusively on unknowingly incorrect, irrefutably insolent and unequivocally irresponsible misguided understanding of a capital market; wherefrom hereto it is undeniable, logical, scientific and intuitively evinced that invoking the aforementioned UCMOST™ information technology directly recognizes, addresses and resolves every and all of the tremendously long-held and enormously heart-felt unmet needs in the relevant art which plead an yearn for a comprehensive and innovative technological solution as an immediate unequivocal absolute resolution to every and all of unmet neeeds in the relevant art, inclusive of a supplanting of every and all of the aforementioned ancient history aforementioned fragementing market inefficiencies. Furthermore, hereto it is an undeniable and evidentary findings of fact, documented reference, logical scientific deduction and intuitive analytical reasoning that every and all unlettered, ignorant, uneducated and unpolished preconceived notions and misconstrued beliefs premised exclusively on spasmodic focus on so-called profits and/or earnings of aforementioned PUBLIC FINANCIALS™ organizations inclusive of without limitation, all of the following: so-called perceived global economic slowdown; so-called lower consumer price index polling numbers of so-called inflation; so-called lower corporate investment in new equipment; so-called declining corporate profits; so-called declining consumer confidence; so-called slower global econometric growth; so-called monetary policies; so-called economic policies, are unequivocally misleading, misguiding, misconstrued and emphatically incorrect preconceived notions of the role and function of individual members of aforementioned PUBLIC FINANCIALS™ organizations inclusive of, without limitation, the role and function of individual individual members of the aforementioned UNIVERSAL POPULACE™, heretfore and hereafter existent, participating, residing and/or operating anywhere, anytime and/or anyplace involving the national sovereign industrialized, developed and developing free-market commerce and trade bloc economies within, throughout and transcending a single holistically econometric marketplace environment. Whereas, it is an undeniable and evidentiary findings of fact, documented reference, logical scientific deduction and intutive analytical reasoning that a capital market is a global theater of operations for a single econometric marketplace environment, which innately and intrinsically entails, encompasses, comprises, involves, impacts and effects every and all basic elemental developments, necessary interactions and integral transactional initiatives, schemes, ocurrences, happenings, interactions, processes, methods, practices, movements, proceedings, messaging, presentations, notifications, filings, submissions, records, activities, actions, events, endeavors, tasks and affairs to serve every and all unmet needs of individual individual members of the aforementioned UNIVERSAL POPULACE™ withwithin a capital market, premised exclusively on sanctified godsend venerational deference virtues and perpetually heart-felt abstract cognitive notions of dignity, compassion, humility, honor, respect, integrity, fairness, truth, justice, faith, trust, ethical, impartial, unprejudiced, unbiased, objective and dispassionate real-time minute per diem conscience exchange of heretofore so-called hard-currency denominated currency payments of so-called cash monies and/or heretofore so-called appropriations and/or topics, issues, matters, elements, components, functions, processess, procedures, designs, systems, devices, forms, factors, ways, parts, segments, methods, combinations, know-how, ideas, art forms, articles of manufacture, discoveries, formulae and/or architectural engineering; wherefrom every and all unlettered, ignorant, unschooled, unknowing, veiling, stalking-horse and/or ephemeral shortsighted steadfast adherence to sanctimonious and/or illogical condescendence inclusive of, without limitation, conceiting and/or irrational insolence premised on so-called experience, so-called earnings, so-called access to wealth, so-called physical materialistic ideologies and/or so. called residual equity earnings of individual members of the aforementioned PUBLIC FINANCIALS™ organiztions inclusive of, without limitation, individual individual members of the aforementioned UNIVERSAL POPULACE™, in no way, shape or form efficiently serves the best interests of the long-term treasure accounting, financial fueling and econometric energizing of individual individual members of the aforementioned UNIVERSAL POPULACE™, inclusive of, without limitation, the best interests of godsend innovative creations, technological advancements, scientific developments, efficient processes, distribution of capital funds, leverage of natural and/or capital resources, maximization of shareholder and/or stakeholder wealth, virtuous and identic cosmopolitan societal developments, global humanitarian propagations. Wherefrom furthermore, and of utmost importance, no unlettered, ignorant, unschooled, unknowing veiling, stalking-horse and/or ephemeral shortsighted steadfast adherence to sanctimonious and/or illogical condescendence inclusive of, without limitation, conceiting and/or irrational insolence premised on so-called experience, so-called earnings, so-called access to wealth, so-called physical materialistic ideologies and/or so-called residual equity earnings of individual individual members of the aforementioned UNIVERSAL POPULACE™ efficiently serves the long-term treasure accounting, financial fueling and econometric energizing of a necessarily increasing and exponentially integral capital market of a single holistically econometric marketplace environment, which hereafter must innately and intrinsically premised exclusively on sanctified godsend venerational deference virtues and perpetually heart-felt abstract cognitive notions of dignity, compassion, humility, honor, respect, integrity, fairness, every and all naturally conceived and created best practices and best executions which incorporate every and all novel developments and innovative technological advancements invoking a capacity to serve the best interests of multitudes of generations of individual members of members of the aforementioned UNIVERSAL POPULACE™, which hereafter shall further inhabit planet earth within the MilkyWay Galaxy solar system well into a future, whence herewith invoking the invention of UCMOST™ information technology. As further evidence of the tempestuous exponentially detrimental exponential increases in systematic volatility which undeniably, respectively, independently, autonomously, evidently, undeniably, logically, scientifically and intuitively derives tempestuous exponentially debilitating exponential increases in cost of capital via propagating, promulgating and proclaiming aforementioned fragmenting capital market inefficiencies it was reported within an article in the business section of the Miami Herald dated Apr. 4, 2001, that the so-called DJ-NYSE composite index concretizing a −350.01 point devaluation during the previous day evinces a so-called closing bell −292.22 point devaluation to a 9,485.71 composite index point level, wherefrom moreover the so-called NASDAQ composite index evinced a −100.01 point devalution during the previous day evincing a 1,673.01 composite index point level, wherefrom as of the printing of the aforementioned article it is widely recognized that within a twelve month period approximately US$5.3 trillion devaluation in market capitalization comparatively nearly one-half of the approximately US$10.5 trillion annual GDP of the so-called U.S., whereof a so-called chief equity strategist vast networks of intermediary aforementioned PUBLIC FINANCIALS™ organizations represent the harming, damaging, inuring, insistent, insinuating, imposing, pestilent, impetuous, importune, pestiferous, condescending and insolent enthralling, hindering, entrapping, pretending, miring, fatiguing, maleficience, harassing, engulfing, pressing, malevolent, presuming, imprinting, malicious, suffocating, miring, strangling, repressing, entangling, pestering and oppressing barriers within the aforementioned fragmenting market inefficiencies apparently referenced in the aforementioned article stipulates there is no greed prevalent within the heretofore capital market albeit he emphatically believes there is ample evindence of widespread fear among the members of the aforementioned propagating the aforementioned fragmented market inefficiencies. Whereas, it is an undeniable and evidentiary findings of fact, documented reference, logical scientific deduction and intuitive analytical reasoning that further propagating aforementioned fragmenting market inefficiencies are evident within the so-called U.S. Department of Treasury specifically within its so-called tax payment collection services on behalf of the so-called U.S., wherefrom the antiquated, archaic, ancient history and superannuated so-called IRS clearly lacks every and all necessarily integrated, critically important and increasing integral information technology to carry-out this function on behalf of the Department of Treasury within the so-called United States of America. Wherefrom, it is an undeniable and evidentiary findings of fact, documented reference, logical scientific deduction and intuitively analytical reasoning that within an article published in the business section of the Miami Herald dated Apr. 5, 2001, is was reported that during a recent audit inquiry from the inspector general for tax administration from its parent the so-called U.S. Department of Treasury posing as typical domestic, expatriate and/or foreign national citizen taxpayers, the workers of the antiquated, archaic, ancient history and superannuated so-called IRS in both face-to-face personal dialogue and telephone dialogue disseminated false and/or incorrect data and information approximately half the time in reference to routine questions related to printed materials from the IRS which stipulate the topics as so-called frequent asked questions listed printed by the antiquated, archaic, ancient history and superannuated IRS related to collections of tax payment filings and settling currency monies within the so-called U.S. Furthermore, it is an undeniable and evidentiary findings of fact, documented reference, logical scientific deduction and intuitive analytical reasoning that within the same article published in the business section of the Miami Herald dated Apr. 5, 2001, is was reported that when spontaneously audited by the inspector general for tax administration of the so-called U.S. Department of Treasury, the telephone calls made to the antiquated, archaic, ancient history and superannuated so-called IRS in pursuit of factual data and information failed to get through wherefrom in combination with an extreme and historical lack of professional service many so-called domestic, expatriate and/or foreign national citizen taxpayers have routinely relied on so-called data and information from the antiquated, complex, inefficient and impersonal telephone system limited to presumptos, pretentious and portentous topics from so-called domestic and/or foreign national citizen taxpayers inclusive of the software thereto has failed due to inadequate design and utility problems, wherefrom the inspector general of tax administration for the so-called U.S. Department of the Treasury reported during a House Ways and Means subcommittee before the so-called U.S. Congress that as a result of lack of every and all necessarily integrated, critically important and increasing integral information technology to efficiently and expediently account, reconcile, audit and report for every and all basic elemental developments, necessary interactions and integral transactional exchange initiatives, schemes, ocurrences, happenings, interactions, processes, methods, practices, movements, proceedings, messaging, presentations, notifications, filings, submissions, records, activities, actions, events, endeavors, tasks and affairs which are hereto discovered prevalent withwithin a capital market it is expected that approximately ten million domestic, expatriate and/or foreign national citizen taxpayers will fail to receive critically necessary service as of year-ending 200 related to collections of tax payment filings and settling currency monies within the so-called U.S., and wherefrom it is herewith undeniably, logically, scientifically and intuitively evinced that every and all, without limitation, of the propagating aforementioned fragmenting capital market inefficiencies prevent it an efficient, effective, functional and integrated aforementioned efficient UNIVERSAL CAPITAL MARKET™ which otherwise concretizes proper services on behalf of the members of the aforementioned UNIVERSAL POPULACE™. Moreover, the inspector general of tax administration for the so-called U.S. Department of the Treasury reported to the House Ways and Means subcommittee before the so-called U.S. Congress that during the so-called spontaneous audit inquiry of the antiquated, archaic andd ancient history so-called IRS, when telephone calls did get answered approximately fifty percent of the so-called frequently asked questions list printed by the IRS were answered with false and/or incorrect data and information, and furthermore when the so-called tapayer assistance centers within eleven different states were visited by the staff of the inspector general of the so-called U.S. Department of Treasury during the spontaneous audit inquiry approximately fifty percent of the time the related to their specific tax filing and legally due payment concerns and issues was false and/or incorrect. Wherefrom, it is an undeniable and evidentiary findings of fact, documented reference, logical scientific deduction and intuitive analytical reasoning that the current commissioner of the antiquated, archaic, ancient history and superannuated so-called IRS also testified and concurred with the characterization by the Secretary of the so-called U.S. Department of Treasury that the levels of service evinced by workers at the antiquated, archaic, ancient history and superannuated so-called IRS inclusive of the lack of every and all, without limitation, of the necessarily integrated, critically important and increasing integral information technology to meet the unmet service needs of the members of the aforementioned UNIVERSAL POPULACE™ with tax payment and/or antiquated, archaic and ancient inappropriate and inefficient so-called early anticipation tax refund inclusive of every and all inappropriate and inefficient so-called tax refund concerns and issues related to the so-called U.S. Department of Treasury tax payment collection are unequivocally unacceptable whence further evincing the heretofore tremendously long-held and enormously heart-felt unmet needs in the relevant art for invoking aforementioned UCMOST™ information technology to materialize formation of a new theater of operations premised on an innovative panacean cutting-edge technological oriented digital bridge platform which establishes propagating, promulgating and proclaiming higher standards of full disclosure, best practices, best executions, enhanced fairness, simultaneous equality, full transparency, consolidated access and perpetual integration of members members of the aforementioned UNIVERSAL POPULACE™ to realize efficient, effective, functional and integrated streamlined, alternating scale, inseparable, seamless and natural wrapping, interlacing, coiling, coupling, combining and interlocking every and all of the distinctively separate and traditionally exclusive specialty areas of public accounting, transport reconciling, independent auditing and financial reporting in connection with actualizing efficient, effective, functional and integrated streamlined, alternating scale, inseparable, seamless and natural wrapping, interlacing, coiling, coupling, combining and interlocking every and all every all of the distinctively separate and traditionally exclusive specialty areas of quotation, clearance, execution, settlement and exchange of insurance, risk financing, MARKET for a necessarily integrated, critically important and increasingly integral aforementioned efficient UNIVERSAL ECONOMY™ on behalf of the hundreds of millions of individual members of the aforementioned UNIVERSAL POPULACE™. It is also an undeniable and evidentiary findings of fact, documented reference, logical scientific deduction and intuitive analytical reasoning that the complexity of even the most basic Forms and Schedules entailing, encompassing, comprising, involving, impacting and/or effecting tax payment collection and tax payment and/or antiquated, archaic and ancient inappropriate and inefficient so-called early anticipation tax refund inclusive of every and all inappropriate and inefficient so-called tax refund from the so-called U.S. Department of Treasury heretofore inefficiently and ineffectively administered and managed by the antiquated, archaic, ancient history and superannuated so-called IRS baffle and bewilder the intelligent minds of individual members of the aforementioned UNIVERSAL POPULACE™ while undermining their time, energy, money and transactional capabilities. Whereas, it is an undeniable and evidentiary findings of fact, documented reference, logical scientific deduction and intuitive analytical reasoning that within an article published in the business section of the Miami Herald, data Apr. 13, 2001, it was referenced that so-called IRS workers recently reported to the so-called U.S. Congress of the United State of America that the most basic aspects of tax law are complicated and contain exceptions and special rules that many domestic, expatriate and/or foreign national individual members of the aforementioned UNIVERSAL POPULACE™ with consequential transactional oriented taxes due to the so-called U.S. Department of Treasury do not understand and are considered extremely excessive to handle every and all income, capital gains, inheritance and/or estate transactional exchange initiatives, schemes, ocurrences, happenings, interactions, processes, methods, practices, movements, proceedings, messaging, presentations, notifications, filings, submissions, records, activities, actions, events, endeavors, tasks and affairs. Whereas, it is an undeniable and evidentiary findings of fact, documented reference, logical scientific deduction and intuitive analytical reasoning that within the within the article published in the business section of the Miami Herald, data Apr. 13, 2001, it was referenced that approximately five hundred and ten thousand domestic, antiquated, archaic, ancient history and superannuated so-called IRS by a minimum of US$311 million more than they were legally due to the so-called U.S. Department of Treasury simply because the complexity of the filing Forms and Schuledes undermining their time, energy, money and transactional capabilities related to appropriately and suitably itemizing every and all of their consequential transactional income, capital gains, inheritance and/or estate transactional exchange initiatives, schemes, ocurrences, happenings, interactions, processes, methods, practices, movements, proceedings, messaging, presentations, notifications, filings, submissions, records, activities, actions, events, endeavors, tasks and affairs led them to transmit the most rudimentary and elemental non-itemized Form 1040-EZ, wherefrom the investigative accounting and reporting arm of the so-called U.S. Congress estimated that predominately most of the domestic, expatriate and/or foreign national individual members of the aforementioned UNIVERSAL POPULACE™ lost an average of approximately US$610 for missing out on a basic deduction for interests charges paid on their mortgage payments for basic housing and shelter. Whereas, it is an undeniable and evidentiary findings of fact, documented reference, logical scientific deduction and intuitive analytical reasoning that the antiquated, archaic, ancient history and superannuated so-called IRS heretofore evinces extreme travesty of obtrusive initiatives, schemes, ocurrences, happenings, interactions, processes, methods, practices, movements, proceedings, messaging, presentations, notifications, filings, submissions, records, activities, actions, events, endeavors, tasks and affairs in its administrative, managerial, accounting, reconciliation, auditing, reporting and collection capacity to service either the so-called U.S. Department of Treasury inclusive of, without limitation, and more importantly the individual members of the aforementioned UNIVERSAL POPULACE™ who are undeniably, logically, scientifically and intuitively legally due for payment of taxes thereto and whom further are the undeniable, logical, scientific and intuitive theoretical and legal owners of the pools of capital deposited with the so-called U.S. Department of Treasury to subsidize the initiatives, schemes, ocurrences, happenings, interactions, processes, methods, practices, movements, proceedings, messaging, presentations, notifications, filings, submissions, records, activities, actions, events, endeavors, tasks and affairs of the so-categorizations and classifications: Defense; Education; Health and Human Services; Housing and Urban Development; International Affairs Programs; Veterans Affiars; Treasury; National Aeronautical and Aerospace Administration; Social Security Administration; Transportation; Agriculture; Justice; Labor; Corps of Engineers; Environmental Protection Agency, Energy, Interior; Commerce and Federal Emergency Management Administration; and furthermore the utlimate beneficiaries of every and all federal initiatives, schemes, ocurrences, happenings, interactions, processes, methods, practices, movements, proceedings, messaging, presentations, notifications, filings, submissions, records, activities, actions, events, endeavors, tasks and affairs. Furthermore, it is an undeniable and evidentiary findings of fact, documented reference, logical scientific deduction and intuitive analytical reasoning, and moreover evinced extreme travesty of obtrusive initiatives, schemes, ocurrences, happenings, interactions, processes, methods, practices, movements, proceedings, messaging, presentations, notifications, filings, submissions, records, activities, actions, events, endeavors, tasks and affairs of the antiquated, archaic, ancient history and superannuated so-called IRS in its administrative, managerial, accounting, reconciliation, auditing, reporting and collection capacity to service either the so-called U.S. Department of Treasury inclusive of, without limitation, and more importantly the individual members of the aforementioned UNIVERSAL POPULACE™ that the so-called IRS commissioner was paradoxically referenced within an article published in the business section of the Miami Herald, dated Apr. 12, 2001, that they should not be tempted to cheat on their tax payment filings because of the level of falling audit rates of the antiquated, archaic, ancient history and superannuated so-called IRS, wherefrom it is also an undeniable and evidentiary findings of fact, documented reference, logical scientific deduction and intuitive analytical reasoning that heretofore, as of the year-ending 2000, less than one-half of one percent of domestic, expatriate and/or foreign national individual members of the aforementioned UNIVERSAL POPULACE™ with consequential transactional oriented taxes due to the so-called U.S. Department of Treasury were subject to an audit of their tax filings and payments due to the so-called U.S. Department of Treasury whence conduit for collections of tax payment filings and settling currency monies on years. Moreover, in evindence of yet another paradoxical reference in light of the undeniable and evidentiary findings of fact, documented reference, logical scientific deduction and intuitive analytical reasoning it was referenced within an article published in the business section of the Miami Herald, dated Apr. 12, 2001, that in spite of their anitquated computers the antiquated, archaic, ancient history and superannuated so-called IRS represent a small portion of the administrative, managerial, accounting, reconciliation, auditing, reporting and collection audit initiatives, schemes, ocurrences, happenings, interactions, processes, methods, practices, movements, proceedings, messaging, presentations, notifications, filings, submissions, records, activities, actions, events, endeavors, tasks and affairs of the so-called IRS, wherefrom the so-called IRS commission was referenced as stating that their computers match taxpayer docments with those provided to the antiquated, archiac and ancient history so-called IRS from the inefficient, ineffective, dysfunctional and fragmented banking, securities and insurance related aforementioned PUBLIC FINANCIALS™ organizations within, throughout and transcending the national sovereign industrialized, developed and developing free-market commerce and trade bloc economies of a single holistically econometric marketplace environment, every and all of whom hereto it is an undeniable and evindentiary findings of fact, documented reference, logical scientific deduction and intuitive analytical reasoning evince a tragic lack the necessary information technology which are necessary to concretize “optimzed” and “efficient” transport flow of real-time processing and/or reprocessing of data and/or information receiver related to accounting, reconciliation, auditing and reporting on every and all consequential transactional income, capital gains, inheritance and/or estate transactional exchange initiatives, schemes, ocurrences, happenings, interactions, processes, methods, practices, movements, proceedings, messaging, presentations, notifications, filings, submissions, records, activities, actions, events, endeavors, tasks and affairs of domestic, expatriate and/or foreign national individual members of the aforementioned UNIVERSAL POPULACE™ with taxes due to the so-called U.S. Department of Treasury the exclusive legally authorized tax payment collection conduit for the so-called United States of America. Furthermore, in evindence of yet another paradoxical reference in light of the undeniable and evidentiary inefficient, ineffective, dysfunctional and fragmented antiquated, archaic, ancient history and superannuated so-called IRS including every and all, without limitation, of its inopportune and obtrusive initiatives, schemes, ocurrences, happenings, interactions, processes, methods, practices, movements, proceedings, messaging, presentations, notifications, filings, submissions, records, activities, actions, events, endeavors, tasks and affairs evincing every and all, without limitation, lack the necessary information technology which are necessary to concretize “optimzed” and “efficient” transport flow of real-time processing and/or reprocessing of data and/or information receiver related to accounting, reconciliation, auditing and reporting on every and all consequential transactional income, capital gains, inheritance and/or estate transactional exchange initiatives, schemes, ocurrences, happenings, interactions, processes, methods, practices, movements, proceedings, messaging, presentations, notifications, filings, submissions, records, activities, actions, events, endeavors, tasks and affairs of domestic, expatriate and/or foreign national individual members of the aforementioned UNIVERSAL POPULACE™ with taxes due to the so-called U.S. Department of Treasury it was referenced within an article published in the business section of the Miami Herald, dated Apr. 13, 2001, that as of the year-ending 1945, the instruction manual for the basic so-called U.S. Department of Treasury Form 1040 did not exceed four pages in length whereof as of year-ending 1955 the same instruction manual for the basic so-called U.S. Department of Treasury Form 1040 did not exceed sixteen pages in length wherefrom by the year-ending 1985 this same instruction manual for the basic Form 1040 reach fifty two pages in length and as of the year-ending 2000 the instruction manual for the basic so-called U.S. Department of Treasury Form 1040 was one hundred and seventeen pages in length, whereof moreover as of the year-ending 2000 it is estimated by a tax watchdog advocate group, namely the National Taxpayers Union, that approximately fifty-eight percent of domestic, expatriate and/or foreign national members of the aforementioned UNIVERSAL POPULACE heretofore require hired assistance whom themselves boisterously offer their so-called professional assistance with antiquated, archaic, ancient history and superannuated information technology, and whom themselves are baffled and bewildered by the antiquated, archaic, ancient history and superannuated so-called IRS in assistance as of the year-ending 2001 and expend approximately 28 hours of time in completing the most basic forms in comparison with 18 hours of time as of the year-ending 1980, wherefrom clearly none of this time incorporates the extensive time, energy, money and patience required to prepare to file and transport payment of taxes to the exclusive legal tax payment collector of the so-called United States of America, namely the so-called U.S. Department of Treasury. Wherefrom, it is an undeniable and evindentiary findings of fact, documented reference, logical scientific deduction and intuitive analytical reasoning that the heretofore fragmented capital market urgently yearns and pleads for innovative information technology to shed light on the tremendously long-held and enormously heart felt unmet needs in the relevant art wherefrom invoking the novel, unobvious, unique, unknown, unforeseen, unprecedented, ease of use and panacean cutting-edge technological innovation heretofore and hereto found existent within the aforementioned UCMOST™ information technology resolves, without exception, every and all inefficient, ineffective, dysfunctional and fragmented market inefficiencies inclusive of, without limitation, every and all of the administrative, managerial, accounting, reconciliation, auditing, reporting and collection extreme travesty of obtrusive initiatives, schemes, ocurrences, happenings, interactions, processes, methods, practices, movements, proceedings, messaging, presentations, notifications, filings, submissions, records, activities, actions, events, endeavors, tasks and affairs of the antiquated, archaic, ancient history and superannuated so-called IRS inclusive of, without limitation, every and all of its lack of necessarily integrated, critically important and increasingly integral computing capabilities heretofrore and hereto existent wherefrom herewith evinced within the aforementioned UCMOST™ information technology. The aforementioned UCMOST™ information technology is furthermore comprehensively suitable, generally pertinent and broadly useful utility and design formulation heretofore and hereto existent to harness and leverage optimally interactive groundbreaking and breakthrough advancements and developments to realize factual holistically steady state indistinguishably synchronized real-time processing of data and/or information receiver content management, financial services and aforementioned PUBLIC FINANCIALS™ instruments transactional exchange initiatives, schemes, ocurrences, happenings, endeavors, tasks and affairs via forming and establishing the aforementioned efficient UNIVERSAL CAPITAL MARKET™ to thereupon and exclusively thereby concretize optimized and efficient transport flow of real-time processing of data and/or information receiver to assist members of the aforementioned UNIVERSAL POPULACE™ in gaining a greater sense of reality of the geoeconomic capital marketplace in which they live, work and play to better understand the hard every and all real-time processing and/or reprocessing of data and/or information receiver precluded from specious, inappropriate, unsuitable and speculative manipulations of every and all real-time processing and/or reprocessing of data and/or information receiver comprehensively suitable, generally pertinent and broadly useful to the real-time economic transactional exchange initiatives, schemes, ocurrences, happenings, interactions, processes, methods, practices, movements, proceedings, messaging, presentations, notifications, filings, submissions, records, activities, actions, events, endeavors, tasks and affairs which entail, encompass, comprise, involve, impact and/or effect every and all national sovereign borders of every and all of the industrialized, developed and developing free-market commerce and trade bloc economies in a single holistically econometric marketplace environment which undeniably, are legally, undeniably, logically, scientifically and intuitively, and intuitively transcend every and all, without limitation, of the multifaceted industries and multidimensional sectors within, throughout and transcending the geographical territories of a single holistically econometric marketplace environment. Additionally, although stock equity aforementioned PUBLIC FINANCIALS™ instruments valuations predominately receive the vogue publication releases in the so-called U.S. and around the world as so-called evidentiary benchmark performance indications members of the aforementioned UNIVERSAL POPULACE™ expectations of the present global economy and anticipations concerning its future, it is less widely recognized that approximately US$15 trillion in bond debt aforementioned PUBLIC FINANCIALS™ instruments are heretofore outstanding in so-called U.S. treasuries, government agency bonds, municipal securities, corporate commercial paper, corporate notes, and corporate bonds in the so-called U.S. alone, and every and all bond debt aforementioned PUBLIC FINANCIALS™ instruments is directly impacted by increases and all aforementioned PUBLIC FINANCIALS™ instruments. At the present pace of transactional exchange volumes in terms of economic unit value in so-called U.S. dollar denomination pertaining to bond debt aforementioned PUBLIC FINANCIALS™ instruments is now approaching US$350 to US$400 billion on a daily basis within the aforementioned fragmenting capital market inefficiencies. This referenced and documented figure of daily transactional exchange initiatives, schemes, ocurrences, happenings, interactions, processes, methods, practices, movements, proceedings, messaging, presentations, notifications, filings, submissions, records, activities, actions, events, endeavors, tasks and affairs in bond debt aforementioned PUBLIC FINANCIALS™ instruments as of the year ending 2000 is evidently more in economic unit sum in so-called U.S. dollar denomination than the total world market capitalization of stock equity aforementioned PUBLIC FINANCIALS™ instruments transactional exchange initiatives, schemes, ocurrences, happenings, interactions, processes, methods, practices, movements, proceedings, messaging, presentations, notifications, filings, submissions, records, activities, actions, events, endeavors, tasks and affairs concretizing as of the year-ending 1969. Moreover, it is clearly an undeniable and evidentiary findings of fact, documented reference, logical scientific deduction and intuitive analytical reasoning that panacean cutting-edge innovations should continue to promulgate a thirst for novel educational knowledge and technologial advancements and developments premised on newly evolving philosophical and theoretical foundations upon which the world can begin to preemptively mitigate tempestuous exponentially detrimental increases in systematic volatility and tempestuous exponentially debilitating increases in the costs of capital within an aforementioned efficient UNIVERSAL CAPITAL MARKET™ to offer members of the aforementioned UNIVERSAL POPULACE™ innovative panacean cutting-edge utility engineering and architectural design propagations universal microprocessor computing design provisions to emancipate and enfranchise themselves form the historical and present entrallment of a vast network of exclusive intermediary members of the aforementioned UNIVERSAL POPULACE™ and their sales driven and commission income staff personnel who continuously impose an undeniable, unnecessary, undeniable, unnecessary, unwarranted, illogical, unjustifiable, unreasoned and unmitigated perpetual threat to their treasure accounting, financial fueling and econometric energizing within the aforementioned fragmenting capital market inefficiencies heretofore inefficient, ineffective, dysfunctional and fragmented W.W. capital markets. At present measurement levels, approximately 30,000 organizations inclusive of, without limitation, public/private organizations, securities exchanges, transactional exchange bankers, pension managers, mutual funds, registered transactional exchange advisors and related organizational enterprises actively are required to report to the so-called U.S. SEC on matter and issues related to the efficient, effective, functional and integrated streamlined, alternating scale, inseparable, seamless and natural wrapping, interlacing, coiling, coupling, combining and interlocking techniques, designs, systems, routines, devices, manners, modes, fashions, forms, formats, factors, objects, parts, segments, elements, components, constituents, ingredients, processes, methods and combinations entailing, encompassing, comprising, involving, impacting and/or effecting automatizing real-time holistically steady state synchronized ubiquitous continuum real-time rhombus microprocessing instantaneous transmission and receiver transforming traverse order-entry quotation, matching, clearance, execution, settlement and exchange of insurance, risk financing, credit, cash management, investment banking, and PUBLIC FINANCIALS™ instruments transactional activities., and present approximately 3,700 aforementioned PUBLIC FINANCIALS™ instruments from members of the aforementioned UNIVERSAL POPULACE™ which directly and/or indirectly participate in registration, as domestic issues or bank intermediary foreign issued american depository receipts (ADR's); and listing aforementioned PUBLIC FINANCIALS™ instruments participate the exchange of their aforementioned PUBLIC FINANCIALS™ instruments via the New York Stock Exchange (NYSE) while approximately 4,000-5,000aforementioned PUBLIC FINANCIALS™ instruments from members of the aforementioned UNIVERSAL POPULACE™ which directly and/or indirectly participate in registration, as domestic issues or bank intermediary foreign issued ADR's, and listing on the National Association of Securities Dealers Automated Quotation (NASDAQ) System. For an example of information disseminated to members of the aforementioned UNIVERSAL and securities industries and sectors inclusive, without limitation, every and all members of the aforementioned UNIVERSAL POPULACE™ pertaining to the distinctively separate and traditionally exclusive specialty areas of the efficient, effective, functional and integrated streamlined, alternating scale, inseparable, seamless and natural wrapping, interlacing, coiling, coupling, combining and interlocking techniques, designs, systems, routines, devices, manners, modes, fashions, forms, formats, factors, objects, parts, segments, elements, components, constituents, ingredients, processes, methods and combinations of public accounting, transport reconciling, independent auditing and financial reporting inclusive of order-entry quotation a Mar. 4, 2000 Miami Herald business section publication reported that economic unit of sum value in so-called U.S. dollar denomination of the largest securities exchange in the world, the so-called physical exchange known as the NYSE was approximately US$12 trillion. It is not surprising that the NASDAQ one of two largest aforementioned PUBLIC FINANCIALS™ instruments exchanges in the world founded approximately in 1968 present lists nearly 4,500-5,000 members of the aforementioned UNIVERSAL POPULACE™ whose aforementioned PUBLIC FINANCIALS™ instruments participate in the NASDAQ exchange, and not as surprisingly given the astonishing appreciation aforementioned PUBLIC FINANCIALS™ instruments in the 1990's the NADSAQ recently displayed an aggregate market capitalization that was nearly as high as the NYSE founded in the eighteenth century. As of the summer of the year-ending 2000, it was reported that an approximate 27,000 aforementioned PUBLIC FINANCIALS™ instruments financial analysts submitted research and analysis reports on the performance and profitability of public/private organizations regarding their operational, aforementioned PUBLIC FINANCIALS™ instruments transactional exchange initiatives, schemes, ocurrences, happenings, interactions, processes, methods, practices, movements, proceedings, messaging, presentations, notifications, filings, submissions, records, activities, actions, events, endeavors, tasks and affairs inclusive of, without limitation, potential public organization comparison to industry and sector wide performance standards of composite research and analysis reports as applicable to those individual members of the aforementioned UNIVERSAL POPULACE™ which have historically registered with the aforementioned PUBLIC FINANCIALS™ instruments of these organizations represented domestic issues or bank intermediary foreign issued ADR's. Although this figures certainly raises questions as to the reconciliation of so-called U.S. government figures relative to reports disseminated to members of the aforementioned UNIVERSAL POPULACE™, the so-called U.S. Federal Reserve has recently been quoted that the economic unit of sum of value in so-called U.S. dollar denomination pertaining to every and all obscurant, irresponsible, feculent, irrational, feckless, disrespectful, mendacious, ignorant, malicious, condescending, untruthful, insolent, inefficient, incognizant, ineffective, fragmenting, unlettered, unpolished, presumptuous, portentous, pretentious, fruitless, disparate, antiquated, archaic, ancient history and superannuated so-called U.S. aforementioned PUBLIC FINANCIALS™ instruments approximates nearly US$40 trillion in sovereign so-called U.S. national balance sheet oriented assets, liabilities and residual equities. Therefore via the Federal Reserve, whose role hereto and composite aggregate measures herein raise serious question, an approximate US$40 trillion inaforementioned PUBLIC FINANCIALS™ instruments are continuously subject to the systematic volatility and increase in the cost of capital which prevail hereto ancient history aforementioned fragementing market inefficiencies. This is somewhat ironic and highly astonishing given that as of 1989 it was published and acknowledged by widely recognized, efficient, effective, objective, well-informed, risk-managed and self-assured competent leaders of a single holistically econometric marketplace environment of economics and finance related to the transactional exchange management profession that the world's total aforementioned PUBLIC FINANCIALS™ instruments totaled at an economic unit sum of value in so-called U.S. dollar denomination which approximated US$12 trillion. It has also been reported in an securities industry sponsored Registered Representative magazine article published April of 2000, that in 1999 on matters relating to NYSE listed public organizationaforementioned PUBLIC FINANCIALS™ instruments transactions and exchanges members of the aforementioned UNIVERSAL POPULACE™ were subjected to US$29.3 billion in commissions, US$11.5 billion in asset management fees and US$6.7 billion in mutual fund sales charges. This Registered Representative magazine article clearly fails to consider the applicable exchange clearing fairness, simulteanoues equality, full transparency, consolidated access and perpetual integration to aforementioned fragmenting capital market inefficiencies, or the less obvious spread differential charges inherent to the actualization of purchasing and/or selling aforementioned PUBLIC FINANCIALS™ instruments aforementioned PUBLIC FINANCIALS™ instruments at separately distinctive economic unit sum of values quoted as the bid and ask spread differential present applicable to every and all aforementioned PUBLIC FINANCIALS™ instruments, nor does the magazine article consider referencing the operational charges, inclusive of, without limitation, the inherent marketing and distribution fees all of the aforementioned which in every and all techniques, designs, systems, routines, devices, manners, modes, fashions, forms, formats, factors, objects, parts, segments, elements, components, constituents, ingredients, processes, methods and combinations are assumed by discounting the economic unit sum of value in so-called U.S. dollar denomination referenced in the accounts members of the aforementioned UNIVERSAL POPULACE™ which pleads for invoked within aforementioned UCMOST™ information technology to emancipate and enfranchise them from the enormously grotesque, exuberant, undeniable, unnecessary, unwarranted, illogical, unjustifiable, unreasoned and unmitigated charges, commissions, fees and surcharges which are assumed by members of the aforementioned UNIVERSAL POPULACE™ necessarily in pursuit of effectuating aforementioned PUBLIC FINANCIALS™ instruments transactional exchange in every and all techniques, designs, systems, routines, devices, manners, modes, fashions, forms, formats, factors, objects, parts, segments, elements, components, constituents, ingredients, processes, methods and combinations. Within the aforementioned fragmenting capital market inefficiencies it is a finding of fact that exuberant amounts of charges, expenses, fees and commissions premised on the economic unit sum of value in so-called U.S. dollar denomination deposited are imposed on members of the aforementioned UNIVERSAL POPULACE™ in pursuit of enhanced fairness, simulteanoues equality, full transparency, consolidated access and perpetual integration to transactional exchange initiatives, schemes, ocurrences, happenings, interactions, processes, methods, practices, movements, proceedings, messaging, presentations, aforementioned UNIVERSAL POPULACE™ which include the slippage spread difference between bid or offer and ask or accept price valuation entailing, encompassing, comprising, involving, impacting and/or effecting automatizing real-time holistically steady state synchronized ubiquitous continuum real-time rhombus microprocessing instantaneous transmission and receiver transforming traverse conduit order-entry quotation, matching, clearance, execution, settlement and exchange of aforementioned PUBLIC FINANCIALS™ instruments. Therefore, and strictly as it pertain to the 1999 Registered Representative magazine publication which only mentions NYSE member firms and the members of the aforementioned UNIVERSAL POPULACE™ listed on its physical exchange, clearly excluding every and all NASDAQ members firms and the members of the aforementioned UNIVERSAL POPULACE™ listed on its electronic exchange, it becomes apparent that in simplified and comprehensive predicate scope analsysis exuberant and unnecessary combinations of surcharges and fees pertaining to access within the inefficient, ineffective, dysfunctional and fragmented so-called U.S. capital market evinced approximately US$47.5 billion dollars charged to members of the aforementioned UNIVERSAL POPULACE™ necessarily in pursuit aforementioned PUBLIC FINANCIALS™ instruments transactions and exchanges. Moreover, the Chicago Board of Options Exchange (CBOE) founded the markets for listed options oriented aforementioned PUBLIC FINANCIALS™ instruments approximately 27 years ago premised on the notion that such derivative oriented aforementioned PUBLIC FINANCIALS™ instruments assist members of the aforementioned UNIVERSAL POPULACE™ in ensuring portfolio insurance functionality and design flexibility in field of developing and managing transactional exchange portfolios. With the heightened interest in aforementioned PUBLIC FINANCIALS™ instruments these listed and traded options contracts whose valuations are derived from the underlying aforementioned PUBLIC FINANCIALS™ statements related to aforementioned PUBLIC FINANCIALS™ instruments of registered members of the aforementioned UNIVERSAL POPULACE™ have recently received wider acclaim and acceptance which inevitably transcended into an area of referred to as alternative risk management premised on the active utilization of these derivative aforementioned PUBLIC differentials, so-called credit card debt risks, so-called weather based risk differentials and other techniques, designs, systems, routines, devices, manners, modes, fashions, forms, formats, factors, objects, parts, segments, elements, components, constituents, ingredients, processes, methods and combinations of passing off risk from one global depositor or pools members of the aforementioned UNIVERSAL POPULACE™ to others via a synthetic form of syndication. With increased requisite for these aforementioned PUBLIC FINANCIALS™ instruments representing stock equity oriented option contracts, the CBOE rapidly became the leading stock equity options oriented aforementioned PUBLIC FINANCIALS™ instruments in the world. The CBOE present actively trades option contracts on more than 1,400aforementioned PUBLIC FINANCIALS™ instruments members of the aforementioned UNIVERSAL POPULACE™ which are either domestic and bank intermediary foreign issued ADR's and 35 stock equity composite indexes, which generates volume for the CBOE of well over one million contracts are transacted and exchanged each and every day. It was also reported in the Mar. 4, 2000 business section publication of the Miami Herald that the London Stock Exchange then listing of approximately 2,750 domestic and foreign members of the aforementioned UNIVERSAL POPULACE™ was approaching aaforementioned PUBLIC FINANCIALS™ instruments value capitalization of nearly US$8.8 trillion. The London Stock Exchange was then contemplating agreements concerning a potential merger with the Frankfurt (Deutsche Boerse) Stock Exchange who then comprised listing of approximately 1,000 domestic and foreign members of the aforementioned UNIVERSAL POPULACE™ was approaching aaforementioned PUBLIC FINANCIALS™ instruments value capitalization of nearly US$15 trillion. These two foreign securities exchanges were considering their potential merger as part of a joint venture with the NASDAQ System in an attempt to form a pan-European electronic securities exchange. In further comprehensive review of the vast network members of the aforementioned UNIVERSAL POPULACE™ which are involved in the vast network of elements which have devised the barriers to entry for individual members of the aforementioned UNIVERSAL POPULACE™ in pursuit of enhanced fairness, simulteanoues equality, full transparency, consolidated access and perpetual integration capital markets representative of a division of Thompson Financial Securities Data reported in March 2000 Forbes magazine publication that as of year-ending 1999 so-called U.S. members of the aforementioned UNIVERSAL POPULACE™ involved in securities underwriting procedures completed more than 17,000 debt and equity issued offerings to members of the aforementioned UNIVERSAL POPULACE™ generating more than US$12 billion in fees for the transactional exchange banks who rendered these intermediary services. Furthermore, as of year-ending 1999 two of the major, top-tier, widely recognized and well-established securities related public organizations earned US$1.9 billion and US$1.7 billion respectively in new offering and intermediary new issue exclusive of secondary offerings, mergers and acquisitions, and every and all other forms aforementioned PUBLIC FINANCIALS™ instruments consulting and related ancillary services. Moreover, as of the year-ending 1999 the debt and equity aforementioned PUBLIC FINANCIALS™ instruments promulgated 540 new issued initial public offerings with a total aforementioned PUBLIC FINANCIALS™ instruments valuation approximating in economic unit sum of value in so-called U.S. dollar denomination of nearly US$69 billion. Further, an Apr. 1, 2000 Miami Herald business section oriented publication reported that the municipal debt oriented underwriting marketplace in the so-called U.S. reached an economic charactery and numismatic metric system unit sum value in so-called U.S. dollar denomination of nearly US$1.5 trillion annually. It is here noted that the municipal securities regulation board (MSRB) present oversees the issuance of municipal government debt underwriting aforementioned PUBLIC FINANCIALS™ instruments offering, thus further evincing the inefficient, ineffective, dysfunctional and fragmented so-called U.S. capital market inclusive, without limitation its regulatory structure and prevalent inefficiencies with respect to distribution channels concerning reporting and booking, classifying, categorizing, adjusting, altering, revising, changing, charging, billing, collecting, producing, composing, conducting, proofing, filtering, pressing, publishing, cataloging, indexing, posting, compressing, releasing, playing, displaying, broadcasting, distributing and/or syndicating transmission, rebroadcasting, redistributing and/or resyndicating transmission which prevent members of the aforementioned UNIVERSAL instruments. In yet another March 2000 Miami Herald business section oriented publication it was reported that the leading industry sponsored bond market association confirmed the total outstanding debt valuation in economic unit sum of value in so-called U.S. dollar denomination pertaining to the so-called U.S. bond debt aforementioned PUBLIC FINANCIALS™ instruments approximated nearly US$15 trillion. The publication further reported that total outstanding so-called U.S. transactional exchange-grade corporate debt oriented aforementioned PUBLIC FINANCIALS™ instruments approximated US$2.4 trillion, and new issues debt aforementioned PUBLIC FINANCIALS™ instruments approximated US$574 billion. It was also reported that of the nearly US$6 billion of transactional exchange-grade corporate bond debt aforementioned PUBLIC FINANCIALS™ instruments transacted and exchange daily in so-called U.S. capital market approximately US$1.5 billion is transacted and exchanged by small capitalized members of the aforementioned UNIVERSAL POPULACE™ and a large majority of these transactions and exchanges are effectuated in non-even numbered odd lot orders to seamlessly and naturally aforementioned PUBLIC FINANCIALS™ instruments transactional exchange initiatives, schemes, ocurrences, happenings, interactions, processes, methods, practices, movements, proceedings, messaging, presentations, notifications, filings, submissions, records, activities, actions, events, endeavors, tasks and affairs It is apparent that aforementioned fragmenting capital market inefficiencies of a single holistically econometric marketplace environment stage present exhibit vast networks of intermediary aforementioned PUBLIC FINANCIALS™ organizations which serve as barriers to enhanced fairness, simulteanoues equality, fill transparency, consolidated access and perpetual integration to the inefficient, ineffective, dysfunctional and aforementioned fragmenting capital market inefficiencies which prohibits enabling tens of hundreds of thousands members of the aforementioned UNIVERSAL POPULACE™ and hundreds of millions members of the aforementioned UNIVERSAL POPULACE™ from around the world to utilities that are capable offering enhanced fairness, simulteanoues equality, full transparency,. consolidated access and perpetual integration to tens of thousands aforementioned PUBLIC FINANCIALS™ instruments oriented aforementioned PUBLIC FINANCIALS™ instruments to actively reference, logical scientific deduction and intuitive analytical reasoning that the vast networks of intermediary aforementioned PUBLIC FINANCIALS™ organizations which employ professional institutional money managers and commission driven account executives clearly do not serve the best interests of unsophisticated members of the aforementioned UNIVERSAL POPULACE™ whom are continuously exposed to extraordinary, grotesque, undeniable, unnecessary, unwarranted, illogical, unjustifiable, unreasoned and unmitigated temptestuous and exponentially increasing systematic volatility and tempetuous and exponentially increasing cost of capital in the global marketplace economy as they are inherently and intrinsically subjected to performance surcharge, charges, fees, expenses, and sales commission oriented from where these vast networks of intermediary aforementioned PUBLIC FINANCIALS™ organizations derive their earnings capacities from individual members of the aforementioned UNIVERSAL POPULACE™ inclusive of, without limitation, every and all so-called commission income and/or high watermark bonus charges as earning employee professional institutional money managers and unknowing, unrestricted, unlettered and unpolished commission earning retail account executives from unfair, circumventing, predatory and malicious undertaking exclusively from transactional exchanges involving individual members of the aforementioned UNIVERSAL POPULACE™ which comprehensively, generally and broadly entail, encompass, comprise, involve, impact and/or effect every and all, without limitation, aforementioned PUBLIC FINANCIALS™ instruments. It is also an undeniable and evidentiary findings of fact, documented reference, logical scientific deduction and intuitive analytical reasoning that these vast networks of intermediary aforementioned PUBLIC FINANCIALS™ organizations represent the harming, damaging, inuring, insistent, insinuating, imposing, pestilent, impetuous, importune, pestiferous, condescending and insolent enthralling, hindering, entrapping, pretending, miring, fatiguing, maleficience, harassing, engulfing, pressing, malevolent, presuming, imprinting, malicious, suffocating, miring, strangling, repressing, entangling, pestering and oppressing barriers to entry to basic elemental developments, necessary interactions and integral transactional exchange initiatives, schemes, ocurrences, happenings, interactions, processes, methods, practices, movements, proceedings, aforementioned UNIVERSAL POPULACE™ to pursue enhanced fairness, simulteanoues equality, full transparency, consolidated access and perpetual integration within a capital market to necessarily deposit and mange their treasure accounting, financial fueling and econometric energizing because they are inherently performance surcharge, charges, fees, expenses, and sales commission oriented thus deriving their earnings capacities as members of the aforementioned UNIVERSAL POPULACE™ and income viasonnel employee professional institutional money managers and retail oriented account executives from unnecessarily high levels aforementioned PUBLIC FINANCIALS™ instruments transactional exchange initiatives members of the aforementioned UNIVERSAL POPULACE™ is innately in contrast to the basic notion of an aforementioned efficient UNIVERSAL CAPITAL MARKET™ and intrinsically tempestuous exponentially detrimental to enabling members of the aforementioned UNIVERSAL POPULACE™ to meet their unmet needs concerning protection, sustenance and expansion are comprehensively suitable, generally pertinent and broadly useful to the treasure accounting, financial fueling and econometric energizing of tens of thousands members of the aforementioned UNIVERSAL POPULACE™ and hundreds of millions members of the aforementioned UNIVERSAL POPULACE™ from around the world. Furthermore, the organizational structured earnings and income methodologies derived from the present marketplace environment with aforementioned fragmenting capital market inefficiencies innately and inherently serves to increase the undeniable, unnecessary, undeniable, unnecessary, unwarranted, illogical, unjustifiable, unreasoned and unmitigated, illogical, unjustifiable and unreasoned systematic volatility and increases in the cost of capital with aforementioned fragmenting capital market inefficiencies thereby continuously enthralling individual members of the aforementioned UNIVERSAL POPULACE™ and erecting greater and more stringent barriers to entry from vast networks of intermediary aforementioned PUBLIC FINANCIALS™ organizations who are preventing members of the aforementioned UNIVERSAL POPULACE™ from achieving enhanced fairness, simulteanoues equality, full transparency, consolidated access and perpetual integration to every and all techniques, designs, systems, routines, devices, manners, modes, fashions, forms, formats, factors, seamlessly and naturally wrapped, twisted, mixed, convoluted, embroidered and combined in connection with aforementioned PUBLIC FINANCIALS™ instruments from members of the aforementioned UNIVERSAL POPULACE™ pertaining to the transactional exchange initiatives, schemes, ocurrences, happenings, interactions, processes, methods, practices, movements, proceedings, messaging, presentations, notifications, filings, submissions, records, activities, actions, events, endeavors, tasks and affairs in every and all global territories involving every and all aforementioned PUBLIC FINANCIALS™ instruments within the aforementioned fragmenting capital market inefficiencies. Whereas, it is an undeniable and evidentiary findings of fact, documented reference, logical scientific deduction and intuitive analytical reasoningal deduction that members of the aforementioned UNIVERSAL POPULACE™ innately and intrinsically pleads for invoked within aforementioned UCMOST™ information technology to utilize an aforementioned efficient UNIVERSAL CAPITAL MARKET™ to systematically meet their unmet information broadcast, financial service and transactional exchange needs to protect, sustain and grow their treasure accounting, financial fueling and econometric energizing within a highly dynamic and inherently volatile, fragile, frigid and ruthless global econometric marketplace environment. Whereas, it is an undeniable and evidentiary findings of fact, documented reference, logical scientific deduction and intuitive analytical reasoning that the basic premise of the aformentioned efficient UNIVERSAL CAPITAL MARKET™ entails, encompasses, comprises, involves, impacts and effects every and all valuation methodologies, performance measurements, organizational structures inclusive of transactional exchange initiatives, schemes, ocurrences, happenings, interactions, processes, methods, practices, movements, proceedings, messaging, presentations, notifications, filings, submissions, records, activities, actions, events, endeavors, tasks and affairs to completely resolve and perpetually meet the tremendously long-held and enormously heart-felt unmet information broadcast, financial service and transactional exchange needs of an aforementioned efficient UNIVERSAL CAPITAL MARKET™ via invoked within aforementioned UCMOST™ information technology as a comprehensively suitable, generally pertinent and broadly useful solution to assist in protecting, sustain and eduction of entailing, encompassing, comprising, involving, impacting and/or effecting every and all basic understanding of the undeniable, unnecessary, undeniable, unnecessary, unwarranted, illogical, unjustifiable, unreasoned and unmitigated, illogical, unjustifiable and unreasoned tempetuous and exponentially increasing systematic volatility inclusive of the undeniable, unnecessary, unwarranted, illogical, unjustifiable, unreasoned and unmitigated tempestuous and exponentially increasing the cost of capital within the aforementioned fragmenting capital market inefficiencies. Whereas, it is an undeniable and evidentiary findings of fact, documented reference, logical scientific deduction and intuitive analytical reasoning that the multifaceted and multidimensional industries and sectors entailing, encompassing, comprising, involving, impacting and/or effecting every and all real-time processing and/or reprocessing of data and/or information receiver, transport, conversion, formatting, processing, saving, storage, identifying, gathering, sorting, organizing, compiling, tabulating, casting, calculating, preparing, editing, verifying, submitting, confirming, validating, booking, classifying, categorizing, adjusting, altering, revising, changing, charging, billing, collecting, producing, composing, conducting, proofing, filtering, pressing, publishing, cataloging, indexing, posting, compressing, releasing, playing, displaying, broadcasting, distributing and/or syndicating transmission, rebroadcasting, redistributing and/or resyndicating transmission inclusive of financial services and transactional exchanges comprehensively in their present aggregate techniques, designs, systems, routines, devices, manners, modes, fashions, forms, formats, factors, objects, parts, segments, elements, components, constituents, ingredients, processes, methods and combinations propagating and promulgate an inefficient, ineffective, dysfunctional and fragmented medium of communicating performance and profitability members of the aforementioned UNIVERSAL POPULACE™ inclusive of, without limitation, aforementioned PUBLIC FINANCIALS™ instrument valuations and comprehensively suitable, generally pertinent and broadly useful transactional exchange data to information to members of the aforementioned UNIVERSAL POPULACE™, and moreover clearly are devoid of propagating, promulgating and proclaiming utility and design to meet the unmet needs members of the aforementioned UNIVERSAL POPULACE™ wherefrom hereto CAPITAL MARKET™ represents for individual members of the aforementioned UNIVERSAL POPULACE™ of a single holistically econometric marketplace environment and propagatings and promulgates continued and perpetual existence of tempetuous and exponentially increasing systematic volatility aforementioned PUBLIC FINANCIALS™ instruments inclusive of tempestuous and exponentially increasing cost of capital within the aforementioned fragmenting capital market inefficiencies. The competitive businessdscape inclusive of legal developments and regulatory initiatives, schemes, ocurrences, happenings, interactions, processes, methods, practices, movements, proceedings, messaging, presentations, notifications, filings, submissions, records, activities, actions, events, endeavors, tasks and affairs present underway in the global marketplace are now awakening to a clear understanding of the importance of changes propagating, promulgating and proclaiming a new theater of operations and higher standards of full disclosure, best practices, best executions, enhanced fairness, simultaneous equality, fill transparency, consolidated access and perpetual integration of individual members of the aforementioned UNIVERSAL POPULACE™ in every and all basic elemental developments, necessary interactions and integral transactional exchange initiatives, schemes, ocurrences, happenings, interactions, processes, methods, practices, movements, proceedings, messaging, presentations, notifications, filings, submissions, records, activities, actions, events, endeavors, tasks and affairs which are hereto discovered prevalent with aforementioned fragmenting capital market inefficiencies, whereby supplanted entirely via invoking the aforementioned UCMOST™ information technology as a comprehensively suitable, generally pertinent and broadly useful solution integrally entailing, encompassing, comprising, involving, impacting and/or effecting every and all techniques, designs, systems, routines, devices, manners, modes, fashions, forms, formats, factors, objects, parts, segments, elements, components, constituents, ingredients, processes, methods and combinations the specialty areas of the efficient, effective, functional and integrated streamlined, alternating scale, inseparable, seamless and natural wrapping, interlacing, coiling, coupling, combining and interlocking techniques, designs, systems, routines, devices, manners, modes, fashions, forms, formats, factors, objects, parts, segments, elements, components, constituents, instantaneous transmission and receiver transforming traverse conduit aforementioned UCMOST™ real-time processing and/or reprocessing of public accounting, transport reconciling, independent auditing and financial reporting inclusive of efficient, effective, functional and integrated streamlined, alternating scale, inseparable, seamless and natural wrapping, interlacing, coiling, coupling, combining and interlocking techniques, designs, systems, routines, devices, manners, modes, fashions, forms, formats, factors, objects, parts, segments, elements, components, constituents, ingredients, processes, methods and combinations entailing, encompassing, comprising, involving, impacting and/or effecting automatizing real-time holistically steady state synchronized ubiquitous continuum real-time rhombus microprocessing instantaneous transmission and receiver transforming traverse conduit aforementioned UCMOST™ real-time processing and/or reprocessing of order-entry quotation, matching, clearance, execution, settlement and exchange of insurance, risk financing, credit, cash management, investment banking and aforementioned PUBLIC FINANCIALS™ instruments. Whereas, to appreciate, comprehend and understand the negative impact of every and all, without limitation, wire jack line and/or wireless technologies, methodologies, capacities, processes, procedures and/or protocols propagating the heretofore inefficient, portentous and fruitless so-called Internet inclusive of, withou limitation, every and all, without limitation, technologies, methodologies, capacities, processes, procedures and/or protocols propagating the heretofore inefficient, portentous and fruitless so-called World Wide Web as a medium of interchange and exchange whereas propagating and promulgating aforementioned fragmenting capital market ineffciencies, the University of Texas at Austin published a 1999 research study report which assessed that the growth of the technologies, methodologies, capacities, processes, procedures and/or protocols propagating the heretofore inefficient, portentous and fruitless so-called Internet premised on so-called wire jack line and/or so-called wireless conduits as an industry in comparison with the communications, aviation and publication industries in terms of business-to-business it is referenced and documented that as of the end of the year 2000, the so-called wire jack line and so-called wireless inefficient, portentous and fruitless so-called Internet has spurred enormous proliferation of growth and is combatting with every and all other deduction and intutive analytical reasoning that there is an tremendously long-held and enormously heart-felt need in the relevant art for concretizing via consummate absolute resolution and constructive reduction to practice every and all, without limitation, innovative techniques, designs, systems, routines, devices, manners, modes, fashions, forms, formats, factors, objects, parts, segments, elements, components, constituents, ingredients, processes, methods and combinations of compositions which are intrinsically and integrally twisted, bundled and combined to offer novel panacean cutting-edge graphical user interfaces, proprietary software programs, software program icons, proprietary operating systems programs, and proprietary operating systems program icons, tailored around innovative techniques, designs, systems, devices, processes, parts, segments, methods, combinations, know-how, ideas, art forms, articles of manufacture, discoveries, formulae, and architectural engineering of streamlined procedural computing process design compositions to offer members of the aforementioned UNIVERSAL POPULACE™ innovative groundbreaking and breakthrough utility engineering and architectural design propagations leveraging and harnessing a heliocentrical universal microprocessor computing design provision to meet their unmet needs in the relevant art whereby forming and establishing new and higher standards within an aforementioned efficient UNIVERSAL CAPITAL MARKET™ which is innovatively capable of mitigating every and all undeniable, unnecessary, undeniable, unnecessary, unwarranted, illogical, unjustifiable, unreasoned and unmitigated, illogical, unjustifiable and unreasoned tempestuous exponentially detrimental increases in systematic volatility inclusive of, without limitation, mitigating every and all tempestuous exponentially debilitating increases in the cost of capital within a single holistic econometric marketplace environment. Whereas, it is an undeniable and evidentiary findings of fact, knowledge and logical scientific deduction reasoning that the large majority of the evolutionary adaptive changes which eventually promulgate positive utility engineering and architectural design propagations evincing a universal microprocessor computing design hereto invoking aforementioned UCMOST enables reformatory provisional changes to mitigate every and all aforementioned fragmenting capital market inefficiencies from a capital market whereby concretizing a novel, unobvious, unknown, the aforementioned UNIVERSAL POPULACE™ a necessary integrated and increasingly integral aforementioned efficient UNIVERSAL ECONOMY™ via innovative groundbreaking and breakthrough utility engineering and architectural design propagations premised on innovative panacean cutting-edge technological bridge oriented digital platform applicable to every and all techniques, designs, systems, routines, devices, manners, modes, fashions, forms, formats, factors, objects, parts, segments, elements, components, constituents, ingredients, processes, methods and combinations involving all basic elemental developments, necessary interactions and integral transactional exchange initiatives, schemes, ocurrences, happenings, interactions, processes, methods, practices, movements, proceedings, messaging, presentations, notifications, filings, submissions, records, activities, actions, events, endeavors, tasks and affairs to supplant every and all, without limitation, conduits of aforementioned fragmenting capital market inefficiencies, whereupon and thereby realizing a utility which is intrinsically useful, inherently pertinent, necessarily integrated, critically important and increasing integral to an aforementioned efficient UNIVERSAL ECONOMY™.The evidentiary enormously tremendously long-held and enormously heart-felt need in the relevant art pertaining to this invention seeks to challenge longstanding traditions and intelligently denounce preconceived notions of the innate foundation of an aforementioned efficient UNIVERSAL CAPITAL MARKET™ by exposing on an industry and sector-wide basis to unsuitable, inefficient and fruitless lack of full disclsoure, best practices, best executions, enhanced fairness, simultaneous equality, fall transparency, consolidated access inclusive of, without limitation, every and all perpetual integration and prevailing market position of harming, damaging, inuring, insistent, insinuating, imposing, pestilent, impetuous, importune, pestiferous, condescending and insolent enthralling, hindering, entrapping, pretending, miring, fatiguing, maleficience, harassing, engulfing, pressing, malevolent, presuming, imprinting, malicious, suffocating, miring, strangling, repressing, entangling, pestering and oppressing individual members of the aforementioned UNIVERSAL POPULACE™ via aforementioned UNIVERSAL CAPITAL MARKET™ communication propagating conceptual aids inclusive of every and all dated methods and inefficient transactional schemes, ocurrences, happenings, interactions, processes, methods, practices, movements, proceedings, messaging, presentations, notifications, filings, submissions, records, activities, actions, events, endeavors, tasks and affairs within an aforementioned efficient UNIVERSAL CAPITAL MARKET™ innately transcend and intrinsically involve the distinctively separate and traditionally exclusive areas of the efficient, effective, functional and integrated streamlined, alternating scale, inseparable, seamless and natural wrapping, interlacing, coiling, coupling, combining and interlocking techniques, designs, systems, routines, devices, manners, modes, fashions, forms, formats, factors, objects, parts, segments, elements, components, constituents, ingredients, processes, methods and combinations of public accounting, transport reconciling, independent auditing and financial reporting inclusive of quotation, clearance, execution, settlement and exchange of insurance, risk financing, credit, cash management, investment banking and aforementioned PUBLIC FINANCIALS™ instruments which requisite an innovative solution entailing, encompassing, comprising, involving, impacting and/or effecting automatizing real-time holistically steady state synchronized ubiquitous continuum real-time rhombus microprocessing instantaneous transmission and receiver transforming traverse conduit order-entry quotation, matching, clearance, execution, settlement and exchange of insurance, risk financing, credit, cash management, investment banking and aforementioned PUBLIC FINANCIALS™ instruments. The enormously tremendously long-held and enormously heart-felt unmet needs in the relevant art yearn and plead for innovative techniques, designs, systems, routines, devices, manners, modes, fashions, forms, formats, factors, objects, parts, segments, elements, components, constituents, ingredients, processes, methods and combinations and necessarily requires formation of a new theater of operations and establishment of higher standards of full disclosure, best practices, best executions, enhanced fairness, simultaneous equality, fill transparency, consolidated access and perpetual integration of members members of the aforementioned UNIVERSAL POPULACE™ within an efficient, effective, functional and integrated aforementioned efficient UNIVERSAL CAPITAL MARKET™ which intrinsically concretizes streamlined, alternating scale, inseparable, seamless and natural wrapping, interlacing, elements, components, constituents, ingredients, processes, methods and combinations entailing, encompassing, comprising, involving, impacting and/or effecting automatizing real-time holistically steady state synchronized ubiquitous continuum real-time rhombus microprocessing instantaneous transmission and receiver transforming traverse conduit to establish a never before seen UNIVERSAL CAPITAL MARKET™ innately and intrinsically premised on actualizing “optimized” and “efficient” flow of public information and aforementioned PUBLIC FINANCIALS™ instrument; to protect, sustain and expand the treasure accounting, financial fueling and econometric energizing of the members of the aforementioned UNIVERSAL POPULACE™ within a necessarily integrated, critically important and increasingly integral efficient UNIVERSAL ECONOMY™. Such a global capital oriented marketplace environment may be capable of enabling reassessment of the accuracy, quality, integrity, honor, timeliness, relevance, transparency, reliabilty, verifiability, comprehensiveness, understandability and assurance of an aforementioned efficient UNIVERSAL CAPITAL MARKET™ inclusive of preconceived notions of what the aforementioned efficient UNIVERSAL CAPITAL MARKET™ entails, encompasses, comprises, involves, impacts and effects for the benefit of tens of hundreds of thousands members of the aforementioned UNIVERSAL POPULACE™ and hundreds of millions members of the aforementioned UNIVERSAL POPULACE™ from around the world who directly and/or indirectly may be unbeknownst to the findings of fact that most of them have an inherently enormously large stake in the present highly dynamic and traditionally and structurally inefficient, ineffective, dysfunctional and fragmented so-called U.S. capital market and traditionally and structurally inefficient, ineffective, dysfunctional and fragmented W.W. capital markets. Moreover, this tremendously long-held and enormously heart-felt need in the relevant art pertaining to this invention involve evidentiary conclusions that lead to analytically devised efficient solutions that strive for improved trust and confidence from members of the aforementioned UNIVERSAL POPULACE™ in senior executives members of the aforementioned UNIVERSAL POPULACE™ whom inevitably manage the operational, aforementioned PUBLIC FINANCIALS™ instruments needs members of the aforementioned UNIVERSAL POPULACE™ involved in raising capital resources completely resolve this void with innovative techniques, designs, systems, devices, processes, parts, segments, methods, combinations, know-how, ideas, art forms, articles of manufacture, discoveries, formulae, and architectural engineering of streamlined procedural computing process design compositions to offer members of the aforementioned UNIVERSAL POPULACE™ innovative groundbreaking and breakthrough utility engineering and architectural design propagations universal microprocessor computing design provisions to meet their unmet needs within an aforementioned efficient UNIVERSAL CAPITAL MARKET™ which are capable of tempestuous diminishing undeniable, unnecessary, undeniable, unnecessary, unwarranted, illogical, unjustifiable, unreasoned and unmitigated, illogical, unjustifiable and unreasoned tempestuous exponentially detrimental increases in systematic volatility and mitigating tempestuous exponentially debilitating increases in the cost of capital in a single holistically econometric marketplace environment. This tremendously long-held and enormously heart-felt need in the relevant art further strives for advancements and improvement in the accuracy, quality, integrity, honor, timeliness, relevance, transparency, reliabilty, verifiability, comprehensiveness, understandability and assurance of the efficient, effective, functional and integrated streamlined, alternating scale, inseparable, seamless and natural wrapping, interlacing, coiling, coupling, combining and interlocking techniques, designs, systems, routines, devices, manners, modes, fashions, forms, formats, factors, objects, parts, segments, elements, components, constituents, ingredients, processes, methods and combinations entailing, encompassing, comprising, involving, impacting and/or effecting automatizing real-time holistically steady state synchronized ubiquitous continuum real-time rhombus microprocessing instantaneous transmission and receiver transforming traverse conduit aforementioned UCMOST™ real-time processing and/or reprocessing of every and all public accounting, transport reconciling, independent auditing and financial reporting inclusive of entailing, encompassing, comprising, involving, impacting and/or effecting automatizing real-time holistically steady state synchronized ubiquitous continuum real-time rhombus microprocessing instantaneous transmission and receiver transforming traverse conduit aforementioned UCMOST™ real-time processing and/or reprocessing of every and all aforementioned PUBLIC FINANCIALS™ instruments particularly as it pertains to fill capacity integral utilization of full disclosure, best practices, best executions, enhanced fairness, simultaneous equality, full transparency, consolidated access and perpetual integration of members members of the aforementioned UNIVERSAL POPULACE™ in every and all basic elemental developments, necessary interactions and integral transactional exchange initiatives, schemes, ocurrences, happenings, interactions, processes, methods, practices, movements, proceedings, messaging, presentations, notifications, filings, submissions, records, activities, actions, events, endeavors, tasks and affairs which requisite enhanced transparency, fairness, enhanced fairness, simulteanoues equality, fill transparency, consolidated access and perpetual integration on behalf of tens of hundreds of thousands members of the aforementioned UNIVERSAL POPULACE™ and hundreds of millions members of the aforementioned UNIVERSAL POPULACE™. These necessarily requisite advancements and improvements may be achievable via innovative panacean cutting-edge technological techniques, designs, systems, routines, devices, manners, modes, fashions, forms, formats, factors, objects, parts, segments, elements, components, constituents, ingredients, processes, methods and combinations that utilize combinatorial elements, multivariate components, novel features and complex figures to completely resolve the enormously tremendously long-held and enormously heart-felt need in the relevant art to enable an increased trust and confidence in senior executives that manage the operational, aforementioned PUBLIC FINANCIALS™ instruments transactional exchange initiatives, schemes, ocurrences, happenings, interactions, processes, methods, practices, movements, proceedings, messaging, presentations, notifications, filings, submissions, records, activities, actions, events, endeavors, tasks and affairs members of the aforementioned UNIVERSAL POPULACE™ from members of the aforementioned UNIVERSAL POPULACE™ who necessarily need to make aforementioned PUBLIC FINANCIALS™ instruments transactional exchange decision initiatives, schemes, ocurrences, happenings, interactions, processes, methods, practices, movements, proceedings, messaging, presentations, notifications, filings, submissions, records, activities, actions, events, endeavors, tasks and affairs utilizing the tens of thousand aforementioned PUBLIC UNIVERSAL POPULACE™ and their senior executive which also necessarily participate within an aforementioned efficient UNIVERSAL CAPITAL MARKET™. The senior executives members of the aforementioned UNIVERSAL POPULACE™ also necessarily utilize the UNIVERSAL CAPITAL MARKET™ to source capital resources to fund their operational, aforementioned PUBLIC FINANCIALS™ instruments needs in pursuit of achieving performance and profitability while promulgating their strategically developed enterprise plans to meet the market requisites of their customers, clients, consumers, constituents and/or citizens. The accuracy, quality, integrity, honor, timeliness, relevance, transparency, reliabilty, verifiability, comprehensiveness, understandability and assurance of an aforementioned efficient UNIVERSAL CAPITAL MARKET™ inclusive of the trust and confidence from members of the aforementioned UNIVERSAL POPULACE™ in the senior executives members of the aforementioned UNIVERSAL POPULACE™ serve as innately critical and multivariate variables which drive aforementioned PUBLIC FINANCIALS™ instruments transactional exchange data and intrinsically generate members of the aforementioned UNIVERSAL POPULACE™ preferential interests and decision-making processes in effectuating one transactional exchange over another within an aforementioned efficient UNIVERSAL CAPITAL MARKET™. The enormously tremendously long-held and enormously heart-felt need in the relevant art strives for innovative techniques, designs, systems, devices, processes, parts, segments, methods, combinations, know-how, ideas, art forms, articles of manufacture, discoveries, formulae, and architectural engineering of streamlined procedural computing process design compositions to offer members of the aforementioned UNIVERSAL POPULACE™ innovative groundbreaking and breakthrough utility engineering and architectural design propagations universal microprocessor computing design provisions which are capable of tempestuous diminishing impulsive reactions from members of the aforementioned UNIVERSAL POPULACE™ due to frantic, frenzied, freaking, frightened and/or spooked panic striken transactional oriented buying and selling by enabling real-time enhanced fairness, simulteanoues equality, full transparency, consolidated access and perpetual integration to aforementioned PUBLIC FINANCIALS™ statements in connection with exchange data with aforementioned PUBLIC FINANCIALS™ instruments transactional exchange information. Ironically, within seconds, minutes, hours, or days the aggregate debt and equity valuations aforementioned PUBLIC FINANCIALS™ instruments concerning transactional exchange initiatives present display extreme fluctuations which can be categorized as systematic volatility and, thus negatively impacting tens of hundreds of thousands members of the aforementioned UNIVERSAL POPULACE™ and hundreds of millions members of the aforementioned UNIVERSAL POPULACE™ from around the world. The inefficient, ineffective, dysfunctional and fragmented so-called U.S. capital market and inefficient, ineffective, dysfunctional and fragmented W.W. capital markets are clearly riddled with and engulfed with numerous tremendously long-held and enormously heart-felt need in the relevant arts that subject tens of trillions of dollars in valuations aforementioned PUBLIC FINANCIALS™ instruments from members of the aforementioned UNIVERSAL POPULACE™ which participate within an aforementioned efficient UNIVERSAL CAPITAL MARKET™ and there is no justifiable or substantive evidentiary and documented scientific reason for every and all of these techniques, designs, systems, routines, devices, manners, modes, fashions, forms, formats, factors, objects, parts, segments, elements, components, constituents, ingredients, processes, methods and combinations of evidentiary systematic risk to exist or even survive hereafter in a UNIVERSAL ECONOMY™ with optimal seamlessly interactive and logical integrated consolidation of every and all recent innovative panacean cutting-edge groundbreaking and breakthrough utitliy engineering and aesthetic architectural design technological advancements and developments in proprietary graphical user interfaces, proprietary software programs and proprietary operating systems development, hardware computing manufacture distribution, artificial satellite, wire-less and wire jack line communications infrastructure, and network routing capacities, hence aforementioned UCMOST™ information technology. Whereas, it is an undeniable and evidentiary findings of fact, documented reference, logical scientific deduction and intuitive analytical reasoningal deductive scientific reasoning that there can be no venue and/or medium involving multivariate innovative techniques, designs, systems, devices, processes, parts, segments, methods, combinations, know-how, ideas, aforementioned UNIVERSAL POPULACE™ innovative groundbreaking and breakthrough utility engineering and architectural design propagations universal microprocessor computing design provisions that can even slightly be considered truly representative of a liquid, transparent and efficient UNIVERSAL CAPITAL MARKET™ unless it is in every and all techniques, designs, systems, routines, devices, manners, modes, fashions, forms, formats, factors, objects, parts, segments, elements, components, constituents, ingredients, processes, methods and combinations the innate form and content of the real-time economic transactional exchange initiatives that take place in the global marketplace. Any such venue, medium, venue and/or medium involving multivariate innovative techniques, designs, systems, devices, processes, parts, segments, methods, combinations, know-how, ideas, art forms, articles of manufacture, discoveries, formulae, and architectural engineering of streamlined procedural computing process design compositions to offer members of the aforementioned UNIVERSAL POPULACE™ innovative groundbreaking and breakthrough utility engineering and architectural design propagations universal microprocessor computing design provisions of providing transactional economic every and all real-time processing and/or reprocessing of data and/or information receiver must ensure that issuers aforementioned PUBLIC FINANCIALS™ instruments meet necessary requisites of a new theater of operation and higher standards of full disclosure, best practices, best executions, enhanced fairness, simultaneous equality, fill transparency, consolidated access and perpetual integration of members members of the aforementioned UNIVERSAL POPULACE™ pertinent to every and all specialty areas related to the efficient, effective, functional and integrated streamlined, alternating scale, inseparable, seamless and natural wrapping, interlacing, coiling, coupling, combining and interlocking techniques, designs, systems, routines, devices, manners, modes, fashions, forms, formats, factors, objects, parts, segments, elements, components, constituents, ingredients, processes, methods and combinations to embroider, harness and leverage the richly infinite, suitable, pertinent and useful potential of forming and establishing an aforementioned efficient UNIVERSAL CAPITAL MARKET™ which naturally invokes aforementioned UCMOST™ information technology requisites necessary legal, regulatory and enhanced fairness, simulteanoues equality, full transparency, consolidated access and perpetual integration to the every and all techniques, designs, systems, routines, devices, manners, modes, fashions, forms, formats, factors, objects, parts, segments, elements, components, constituents, ingredients, processes, methods and combinations aforementioned PUBLIC FINANCIALS™ statements seamlessly and naturally wrapped, twisted, mixed, convoluted, embroidered and combined in connection with aforementioned PUBLIC FINANCIALS™ instruments from members of the aforementioned UNIVERSAL POPULACE™ real-time full disclosure, best practices, best executions, enhanced fairness, simulteanoues equality, full transparency, consolidated access and perpetual integration to aforementioned PUBLIC FINANCIALS™ instruments valuation data and aforementioned PUBLIC FINANCIALS™ instruments non-financial transactional information without every and all present traditionally enthrallment from the vast networks of antiquated, archaic, ancient history and superannuated aforementioned PUBLIC FINANCIALS™ organizations involved hereto ancient history aforementioned fragementing market inefficiencies. Within an aforementioned efficient UNIVERSAL CAPITAL MARKET™ which naturally invokes aforementioned UCMOST™ information technology inclusive of every and all techniques, designs, systems, routines, devices, manners, modes, fashions, forms, formats, factors, objects, parts, segments, elements, components, constituents, ingredients, processes, methods and combinations are comprehensively suitable, generally pertinent and broadly useful to concretize full disclosure, best practices, best executions, enhanced fairness, simultaneous equality, full transparency, consolidated access and perpetual integration of members members of the aforementioned UNIVERSAL POPULACE™. Thus, such a venue and/or medium involving multivariate innovative techniques, designs, systems, devices, processes, parts, segments, methods, combinations, know-how, ideas, art forms, articles of manufacture, discoveries, formulae, and architectural engineering of streamlined procedural computing process design compositions to offer members of the aforementioned UNIVERSAL POPULACE™ innovative groundbreaking and breakthrough utility engineering and architectural design propagations universal microprocessor computing design provisions routines, devices, manners, modes, fashions, forms, formats, factors, objects, parts, segments, elements, components, constituents, ingredients, processes, methods and combinations of reliability, timeliness, efficiency, effectiveness, UNIVERSAL CAPITAL MARKET™ security, and more importantly be fully capable of retrieving, processing, storing, booking, classifying, categorizing, adjusting, altering, revising, changing, charging, billing, collecting, producing, composing, conducting, proofing, filtering, pressing, publishing, cataloging, indexing, posting, compressing, releasing, playing, displaying, broadcasting, distributing and/or syndicating transmission, rebroadcasting, redistributing and/or resyndicating transmission, distributing, and syndicating every and all real-time processing and/or reprocessing of data and/or information receiver from public organization in real-time automatizing to provide multivariate utility benefit oriented offerings to members of the aforementioned UNIVERSAL POPULACE™ from around the world encompassing real-time enhanced fairness, simulteanoues equality, full transparency, consolidated access and perpetual integration to every and all technique, designs, systems, routines, devices, manners, modes, fashions, forms, formats, factors, objects, parts, segments, elements, components, constituents, ingredients, processes, methods and combinations aforementioned PUBLIC FINANCIALS™ statements seamlessly and naturally wrapped, twisted, mixed, convoluted, embroidered and combined in connection with aforementioned PUBLIC FINANCIALS™ instruments from members of the aforementioned UNIVERSAL POPULACE™ real-time full disclosure, best practices, best executions, enhanced fairness, simulteanoues equality, full transparency, consolidated access and perpetual integration to aforementioned PUBLIC FINANCIALS™ instruments transactional exchange data and PUBLIC FINANCIALS™ transactional exchange instruments non-financial information pertaining to a never before seen UNIVERSAL CAPITAL MARKET™ for a necessarily integrated, critically important and increasing integral aforementioned efficient UNIVERSAL ECONOMY™, and which thereupon it must innately pursue continuous innovations.

4. Public Capital Market Law

The legal environment surrounding aforementioned fragmenting capital market inefficiencies can be surmised by effectively understanding the premise of law which heretofore govern, propagate, proliferate and promulgate multitudes of aforementioned fragmenting capital market inefficiencies are adhered to and complied with to the full extent of their letter, spirit and nature inclusive of, without limitation, their scope, breadth and depth. According to an article dated Nov. 13, 1999 in a Miami Herald business section publication so-called U.S. depositors accessing the aforementioned fragmenting capital market inefficiencies to seamlessly and naturally financial service and transactional exchange decision-making processes expend US$350 billion a year on banking, insurance, and securities related service fees and commissions, albeit this figures most likely fails to incorporate every and all applicable surcharge, charges, fees, expenses, and sales commissions applicable to managing and transactional exchange aforementioned PUBLIC FINANCIALS™ instruments hereto ancient history aforementioned fragementing market inefficiencies. The aforementioned UCMOST™ information technology may be capable of ensuring that full capacity utilization of full disclosure, best practices, best executions, enhanced fairness, simultaneous equality, full transparency, consolidated access and perpetual integration of members members of the aforementioned UNIVERSAL POPULACE™ becomes the premise for offering members of the aforementioned UNIVERSAL POPULACE™ fill disclosure, best practices, best executions, enhanced fairness, simulteanoues equality, full transparency, consolidated access and perpetual integration to aforementioned fragmenting capital market inefficiencies via establishment of a novel, unobvious, unique, unknown, unforeseen and unprecedented UNIVERSAL CAPITAL MARKET™ for a necessarily integrated, critically important and increasing integral aforementioned efficient UNIVERSAL ECONOMY™. It is now becoming ever more apparent to participants with aforementioned fragmenting capital market inefficiencies that members of the aforementioned UNIVERSAL POPULACE™ who necessarily participate within an aforementioned efficient UNIVERSAL CAPITAL MARKET™ and in most techniques, designs, systems, routines, devices, manners, modes, fashions, forms, formats, factors, objects, parts, segments, elements, components, constituents, ingredients, processes, format; factors, objects parts segments, elements, components constituents ingredients, processes, methods and combinations of novel venues and/or mediums involving multivariate innovative techniques, designs, systems, devices, processes, parts, segments, methods combinations, know-how, ideas, art forms, articles of manufacture, discoveries, formulae, and architectural engineering of streamlined procedural computing process design compositions to offer members of the aforementioned UNIVERSAL POPULACE™ innovative groundbreaking and breakthrough utility engineering and architectural design propagations universal microprocessor computing design provisions to ensure they are offered a never before seen capacity to self-manage and deposit their ownaforementioned PUBLIC FINANCIALS™ instruments to protect, sustain and expand their treasure accounting, financial fueling and econometric energizing in a highly dynamic and integrally risk oriented transactional exchange driven marketplace environment. The aforementioned UCMOST™ information technology in its fully capacity commercialized implementation can never hold members of the aforementioned UNIVERSAL POPULACE™ and their respective senior executive officers, board directors, governing bodies, regulatory authorities, internal auditors, audit committee members and independent auditors to less stringent standards of full disclosure, best practices, best executions, enhanced fairness, simultaneous equality, fill transparency, consolidated access and perpetual integration of members members of the aforementioned UNIVERSAL POPULACE™ related to areas of the efficient, effective, functional and integrated streamlined, alternating scale, inseparable, seamless and natural wrapping, interlacing, coiling, coupling, combining and interlocking techniques, designs, systems, routines, devices, manners, modes, fashions, forms, formats, factors, objects, parts, segments, elements, components, constituents, ingredients, processes, methods and combinations entailing, encompassing, comprising, involving, impacting and/or effecting automatizing real-time holistically steady state synchronized ubiquitous continuum real-time rhombus microprocessing instantaneous transmission and receiver transforming traverse conduit aforementioned UCMOST™ real-time processing and/or reprocessing of public accounting, transport reconciling, independent auditing and financial reporting inclusive of efficient, effective, functional and integrated streamlined, alternating scale, forms, formats, factors, objects, parts, segments, elements, components, constituents, ingredients, processes, methods and combinations entailing, encompassing, comprising, involving, impacting and/or effecting automatizing real-time holistically steady state synchronized ubiquitous continuum real-time rhombus microprocessing instantaneous transmission and receiver transforming traverse conduit aforementioned UCMOST™ real-time processing and/or reprocessing of order-entry quotation, matching, clearance, execution, settlement and exchange of insurance, risk financing, credit, cash management, investment banking and aforementioned PUBLIC FINANCIAL™ instruments to offer members of the aforementioned UNIVERSAL POPULACE™ real-time full disclosure, best practices, best executions, enhanced fairness, simulteanoues equality, full transparency, consolidated access and perpetual integration to automatizing real-time transmission propagating transporting transmuting partible beta particle beam gliding transponder converting receiver conduit aforementioned UCMOST™ real-time processing and/or reprocessing via encasing, embroidering, harnessing and leveraging every and all of the aforementioned UNIVERSAL CAPITAL MARKET™ communication propagating the conceptual aids heretofore are comprehensively imprudent, generally insolent and broadly unacceptable traversing every and all techniques, designs, systems, routines, devices, manners, modes, fashions, forms, formats, factors, objects, parts, segments, elements, components, constituents, ingredients, processes, methods and combinations aforementioned PUBLIC FINANCIALS™ statements seamlessly and naturally wrapped, twisted, mixed, convoluted, embroidered and combined in connection with aforementioned PUBLIC FINANCIALS™ instruments from members of the aforementioned UNIVERSAL POPULACE™ real-time full disclosure, best practices, best executions, enhanced fairness, simulteanoues equality, full transparency, consolidated access and perpetual integration to automatizing real-time transmission propagating transporting transmuting partible beta particle beam gliding transponder converting receiver conduit aformentiond UCMOST real-time processing and/or reprocessing of every and all aforementioned UNIVERSAL CAPITAL MARKET™ communication propagating the conceptual aids, which clearly, undeniably, logically, scientifically and intutively heretofore are aforementioned PUBLIC FINANCIALS™ instruments non-financial transactional information. The preliminary business oriented market research of the sole proprietor independent inventor of aforementioned UCMOST™ information technology which are comprehensively suitable, generally pertinent and broadly useful to the commercial benefits and potential salability of this invention evinced that the legal environment is actively in pursuit of a new theater of operations and higher standards of full disclosure, best practices, best executions, enhanced fairness, simultaneous equality, full transparency, consolidated access and perpetual integration of members members of the aforementioned UNIVERSAL POPULACE™ to ensure steadfast adherence and fully enforceable compliance with every and all obscurant, irresponsible, feculent, irrational, feckless, disrespectful, mendacious, ignorant, malicious, condescending, untruthful, insolent, inefficient, incognizant, ineffective, fragmenting, unlettered, unpolished, presumptuous, portentous, pretentious, fruitless, disparate, antiquated, archaic, ancient history and superannuated so-called U.S. securities laws, governing rules and authoritative regulations within a capital market are comprehensively suitable, generally pertinent and broadly useful holistically steady state continuous spectrum ubiquitous indistinguishably synchronous needs involving aforementioned UCMOST™ real-time processing and/or reprocessing of data and/or information content management, financial services and aforementioned PUBLIC FINANCIALS™ instruments transactional exchange initiatives, schemes, ocurrences, happenings, interactions, processes, methods, practices, movements, proceedings, messaging, presentations, notifications, filings, submissions, records, activities, actions, events, endeavors, tasks and affairs. In a article dated Nov. 5, 1999 in a Miami Herald business section it was reported that the senate of the so-called U.S. Congress approveddmark congressional legislation that removes Depression-era archaic barriers to allow most public enterprises involved in the NYSE and NASDAQ member broker-dealer vast network of exclusive intermediary members of the aforementioned UNIVERSAL POPULACE™ which participate with aforementioned fragmenting capital market inefficiencies, and thus every and all banking, securities and insurance related members of the aforementioned UNIVERSAL POPULACE™ to enter into each others commercial enterprises to offer members of the initiatives, schemes, ocurrences, happenings, interactions, processes, methods, practices, movements, proceedings, messaging, presentations, notifications, filings, submissions, records, activities, actions, events, endeavors, tasks and affairs. Whereas, it is an undeniable and evidentiary findings of fact, documented reference, logical scientific deduction and intuitive analytical reasoning that members of the aforementioned UNIVERSAL POPULACE™ entailing, encompassing, comprising, involving, impact and/or effecting the clearance and settlement of financial services and aforementioned PUBLIC FINANCIALS™ instruments transactional exchange initiatives, schemes, ocurrences, happenings, interactions, processes, methods, practices, movements, proceedings, messaging, presentations, notifications, filings, submissions, records, activities, actions, events, endeavors, tasks and affairs historically and present obscurely engage in large-scale and wide-spread fraudulent initiatives, schemes, ocurrences, happenings, interactions, processes, methods, practices, movements, proceedings, messaging, presentations, notifications, filings, submissions, records, activities, actions, events, endeavors, tasks and affairs are comprehensively suitable, generally pertinent and broadly useful financial services and aforementioned PUBLIC FINANCIALS™ instruments transactional exchange initiatives, schemes, ocurrences, happenings, interactions, processes, methods, practices, movements, proceedings, messaging, presentations, notifications, filings, submissions, records, activities, actions, events, endeavors, tasks and affairs wherein untold numbers members of the aforementioned UNIVERSAL POPULACE™ having suffered, been injured and financially harmed at the hands of these incriminating charges. Within an article published in the business section of the Miami Herald dated Feb. 11, 2001, it was reported that one major, top-tier, widely recognized and well-established securities related public organization, via its subsidiary public organization, whose is one of a single holistically econometric marketplace environment's leading public organization involved in the clearance and settlement of financial services and aforementioned PUBLIC FINANCIALS™ instruments transactional exchange initiatives, schemes, ocurrences, happenings, interactions, processes, methods, practices, movements, proceedings, messaging, presentations, notifications, filings, submissions, records, activities, actions, events, district attorney in the city of Manhattan of the State of New York where the so-called historical and archaic so-called Wall Street is headquarted inherently because of the concentration of the vast Networks of exclusive intermediary members of the aforementioned UNIVERSAL POPULACE™ which heretofore engulf, enthrall and oppress aforementioned fragmenting capital market inefficiencies. The article published in the business section of the Miami Herald dated Feb. 11, 2001, further reported that this single case of fraud exposed by the so-called U.S. SEC and the so-called U.S. district attorney in the city of Manhattan of the State of New York in August of 1999 shed tremendous light and enormous public awareness on the large-scale and wide-spread actualization of material aiding fraudulent transaction initiatives, schemes, ocurrences, happenings, interactions, processes, methods, practices, movements, proceedings, messaging, presentations, notifications, filings, submissions, records, activities, actions, events, endeavors, tasks and affairs of clearance and settlement entailing, encompassing, comprising, involving, impact and/or effecting every and all financial services and aforementioned PUBLIC FINANCIALS™ instruments transactional exchange initiatives, schemes, ocurrences, happenings, interactions, processes, methods, practices, movements, proceedings, messaging, presentations, notifications, filings, submissions, records, activities, actions, events, endeavors, tasks and affairs with aforementioned fragmenting capital market inefficiencies are comprehensively suitable, generally pertinent and broadly useful members of the aforementioned UNIVERSAL POPULACE™, wherein the subsidiary public organization of the heretofore major, top-tier, widely recognized and well-established securities related public organization was charged with fraud involving a now defunct NASD member broker-dealer of the vast Networks of exclusive intermediary members of the aforementioned UNIVERSAL POPULACE™ which engulf, enthrall and oppress members of the aforementioned UNIVERSAL POPULACE™, which evinced that members of the aforementioned UNIVERSAL POPULACE™ were subject to having suffered, been injured and financially harmed in the amount of US$75 million and the parent firm of the subsidiary public organization role therein settled the case mantter via US$42 million in fines and restitution who suffered these extravagant and unacceptable monetary figures. organization via which it engaged in clearance and settlement entailing, encompassing, comprising, involving, impact and/or effecting every and all financial services and aforementioned PUBLIC FINANCIALS™ instruments transactional exchange initiatives, schemes, ocurrences, happenings, interactions, processes, methods, practices, movements, proceedings, messaging, presentations, notifications, filings, submissions, records, activities, actions, events, endeavors, tasks and affairs from members of the aforementioned UNIVERSAL POPULACE™ was charged with fraud via propagating excesssive commission charges to a member members of the aforementioned UNIVERSAL POPULACE™ as recently as January, 2001, wherein arbitrators of the case matter identified that member members of the aforementioned UNIVERSAL POPULACE™ was subjugated to arbitration via the contract engagement of the now defunct NASD member-broker dealer as typically requited per the policies of the heretofore major, top-tier, widely recognized and well-established securities related banking, securities and insurance related members of the aforementioned UNIVERSAL POPULACE™, awarded sanctions of US$178 thousand to the member members of the aforementioned UNIVERSAL POPULACE™ for having suffered, been injured and financially harmed as a function of the fraudulent clearance and settlement initiatives, schemes, ocurrences, happenings, interactions, processes, methods, practices, movements, proceedings, messaging, presentations, notifications, filings, submissions, records, activities, actions, events, endeavors, tasks and affairs of the subsidiary of the parent public organization. Whereas, it is an undeniable and evidentiary findings of fact, documented reference, logical scientific deduction and intuitive analytical reasoning that historically and present every and all of the banking, securities and insurance related members of the aforementioned UNIVERSAL POPULACE™ and/or their subsidiary NYSE and NASD member broker-dealers of the vast network of exclusive intermediary members of the aforementioned UNIVERSAL POPULACE™ which participate with aforementioned fragmenting capital market inefficiencies have consistently subjugated members of the aforementioned UNIVERSAL POPULACE™ to a subservient medium of arbitration to settle out of a court of law every and all claims of damages and futhrer every and all potential charges of fraud, illegalities and improprieties filed against them related members of the aforementioned UNIVERSAL POPULACE™ and/or their subsidiary NYSE and NASD member broker-dealers of the vast network of exclusive intermediary members of the aforementioned UNIVERSAL POPULACE™, their subsidiary members of the aforementioned UNIVERSAL POPULACE™ and/or their commission driven account executives. Whereas, it is an undeniable and evidentiary findings of fact, documented reference, logical scientific deduction and intuitive analytical reasoning this so-called subjugation of exclusive medium of arbitration is reputedly the largest and most widely utilized syndicate of its kind in the world thereby precluding and subjugating every and all members of the aforementioned UNIVERSAL POPULACE™ from shedding tremendous light and enormous public awareness of their having suffered, been injured and financially harmed via the useful proceedings involving every and all trial court depositions, forms of discovery and potential jury trial arguments and summations concerning and pertaining every and all for having suffered, been injured and financially harmed by every and all banking, securities and insurance related members of the aforementioned UNIVERSAL POPULACE™ and/or their subsidiary NYSE and NASD member broker-dealers of the vast network of exclusive intermediary members of the aforementioned UNIVERSAL POPULACE™, their subsidiary members of the aforementioned UNIVERSAL POPULACE™ and/or their commission driven account executives as a function of the fraudulent clearance and settlement entailing, encompassing, comprising, involving, impact and/or effecting every and all financial services and aforementioned PUBLIC FINANCIALS™ instruments transactional exchange initiatives, schemes, ocurrences, happenings, interactions, processes, methods, practices, movements, proceedings, messaging, presentations, notifications, filings, submissions, records, activities, actions, events, endeavors, tasks and affairs with aforementioned fragmenting capital market inefficiencies. It is further an undeniable and evidentiary findings of fact, documented reference, logical scientific deduction and intuitive analytical reasoning that best interests members of the aforementioned UNIVERSAL POPULACE™ are not served via this subjugation to this medium which envices the historical and present harming, damaging, inuring, insistent, insinuating, imposing, pestilent, impetuous, importune, pestiferous, condescending and insolent comprising, involving, impact and/or effecting every and all basic functional elements, necessary interactions and aforementioned PUBLIC FINANCIALS™ instruments transactional exchange initiatives, schemes, ocurrences, happenings, interactions, processes, methods, practices, movements, proceedings, messaging, presentations, notifications, filings, submissions, records, activities, actions, events, endeavors, tasks and affairs involving members of the aforementioned UNIVERSAL POPULACE™ entailing, encompassing, comprising, involving, impact and/or effecting every and all financial services and aforementioned PUBLIC FINANCIALS™ instruments transactional exchange initiatives, schemes, ocurrences, happenings, interactions, processes, methods, practices, movements, proceedings, messaging, presentations, notifications, filings, submissions, records, activities, actions, events, endeavors, tasks and affairs with aforementioned fragmenting capital market inefficiencies by every and all banking, securities and insurance related members of the aforementioned SUNIVERAL POPULACE™ and/or their subsidiary NVSP and NASD member broker-dealers of the vast network of exclusive intermediary members of the aforementioned UNIVERSAL POPULACE™, their subsidiary members of the aforementioned UNIVERSAL POPULACE™ and/or their commission driven account executives. It is also an undeniable and evidentiary findings of fact, documented reference, logical scientific deduction and intuitive analytical reasoning that every and all of the aforementioned subjugation members of the aforementioned UNIVERSAL POPULACE™ are comprehensively suitable, generally pertinent and broadly useful subjugated preclusion of their right to necessary intervention of truth, fairness and justice entailing, encompassing, comprising, involving, impact and/or effecting every and all basic functional elements, necessary interactions and aforementioned PUBLIC FINANCIALS™ instruments transactional exchange initiatives, schemes, ocurrences, happenings, interactions, processes, methods, practices, movements, proceedings, messaging, presentations, notifications, filings, submissions, records, activities, actions, events, endeavors, tasks and affairs via publicity useful proceedings involving every and all trial court depositions, forms of discovery and potential jury trial arguments and summations concerning and pertaining every and all for having suffered, been injured NYSE and NASD member broker-dealers of the vast network of exclusive intermediary members of the aforementioned UNIVERSAL POPULACE™, their subsidiary members of the aforementioned UNIVERSAL POPULACE™ and/or their commission driven account executives is emphatically and undeniable, inefficient, ineffective, dysfunctional and evinces and and all propogatation of consistent historical and present harming, damaging, inuring, insistent, insinuating, imposing, pestilent, impetuous, importune, pestiferous, condescending and insolent enthrallment, pretend, harass, engulf, press, presume, imprint, pester and oppress every and all necessary intervention of truth, fairness and justice via prudent venues, jurisdictions and methods of court of law every and all claims of damages and futhrer every and all potential charges of fraud, illegalities and improprieties filed against them by members of the aforementioned UNIVERSAL POPULACE™ for having suffered, been injured and financially harmed by every and all banking, securities and insurance related members of the aforementioned UNIVERSAL POPULACE™ and/or their subsidiary NYSE and NASD member broker-dealers of the vast network of exclusive intermediary members of the aforementioned UNIVERSAL POPULACE™, their subsidiary members of the aforementioned UNIVERSAL POPULACE™ and/or their commission driven account executives which typically occur, happen and/or transpire as evidentiary large-scale and widespread contagion and entails, encompasses, comprises, involvves, impacts and effects every and all banking, securities and insurance related members of the aforementioned UNIVERSAL POPULACE™ and/or their subsidiary NYSE and NASD member broker-dealers of the vast network of exclusive intermediary members of the aforementioned UNIVERSAL POPULACE™, their subsidiary members of the aforementioned UNIVERSAL POPULACE™ and/or their commission driven account executives with aforementioned fragmenting capital market inefficiencies inclusive of, without limitation, every and all quotation, matching, clearance, settlement and exchange of financial services and aforementioned PUBLIC FINANCIALS™ instruments transactional exchange initiatives, schemes, ocurrences, happenings, interactions, processes, methods, practices, movements, proceedings, messaging, presentations, notifications, filings, submissions, records, activities, actions, events, endeavors, tasks and affairs from members of the aforementioned UNIVERSAL spread fraudulent initiatives, schemes, ocurrences, happenings, interactions, processes, methods, practices, movements, proceedings, messaging, presentations, notifications, filings, submissions, records, activities, actions, events, endeavors, tasks and affairs are comprehensively suitable, generally pertinent and broadly useful financial services and aforementioned PUBLIC FINANCIALS™ instruments transactional exchange initiatives, schemes, ocurrences, happenings, interactions, processes, methods, practices, movements, proceedings, messaging, presentations, notifications, filings, submissions, records, activities, actions, events, endeavors, tasks and affairs it is clearly an undeniable and evidentiary findings of fact, documented reference, logical scientific deduction and intuitive analytical reasoning that historically when arbitrators publicized the adjudications, settlements, and potential damages and/or sanction awards wherein the presided over the case matter they typically offered members of the aforementioned UNIVERSAL POPULACE™ no details and opinions on the evidentiary findings of facts surrounding case matters, but a recent US$1.8 million sanctioned award to a handful of members members of the aforementioned UNIVERSAL POPULACE™ which effectuated financial services and aforementioned PUBLIC FINANCIALS™ instruments transactional exchange initiatives, schemes, ocurrences, happenings, interactions, processes, methods, practices, movements, proceedings, messaging, presentations, notifications, filings, submissions, records, activities, actions, events, endeavors, tasks and affairs via a now defunct NASD member broker-dealer from the State of Oregon evinced that another major, top-tier, widely recognized and well-established banking related public organization, via its subsidiary public organization, which is one of a single holistically econometric marketplace environment's leading members of the aforementioned UNIVERSAL POPULACE™ involved in the clearance and settlement of financial services and aforementioned PUBLIC FINANCIALS™ instruments transactional exchange initiatives, schemes, ocurrences, happenings, interactions, processes, methods, practices, movements, proceedings, messaging, presentations, notifications, filings, submissions, records, activities, actions, events, endeavors, tasks and affairs are comprehensively suitable, generally pertinent and broadly useful banking related members of the aforementioned UNIVERSAL POPULACE™ engaged under the interactions and aforementioned PUBLIC FINANCIALS™ instruments transactional exchange initiatives, schemes, ocurrences, happenings, interactions, processes, methods, practices, movements, proceedings, messaging, presentations, notifications, filings, submissions, records, activities, actions, events, endeavors, tasks and affairs materially aided fraudulent transactions against members members of the aforementioned UNIVERSAL POPULACE™ via the now defunct NASD member broker-dealer from the State of Oregon. Whereas, it is an undeniable and evidentiary findings of fact, documented reference, logical scientific deduction and intuitive analytical reasoning that in this particular cash matter under their presiding power as arbitrators, they subsequently in cohesive and comprehensive manners as a panel deposited the time to write an extrodinarily lengthly, thorough and twenty-five page reasoned explanation of why the arrived at the judement and sanctioned award of US$1.8 million to the handful of members members of the aforementioned UNIVERSAL POPULACE™, and it is reported they engaged in a breakthrough are comprehensively suitable, generally pertinent and broadly useful to the historic and archaic tradition implementing subjugated restraining orders on the proceedings, findings and adjudications of case matters involving banking, securities and insurance related members of the aforementioned UNIVERSAL POPULACE™ in an effort to set an example for other arbitrators in future case matters are comprehensively suitable, generally pertinent and broadly useful NYSE and NASD member broker-dealers of the vast network of exclusive intermediary members of the aforementioned UNIVERSAL POPULACE™ which historically and evidently present engulf, enthrall, oppress and futhermore subjugate members of the aforementioned UNIVERSAL POPULACE™ further restraining their mediums of indirectly publicizing every and all claims of damages for having suffered, been injured and financially harmed, and further every and all potential charges of fraud, illegalities and improprieties filed against NYSE and NASD banking, securities and insurance related member broker-dealers of the vast network of exclusive intermediary members of the aforementioned UNIVERSAL POPULACE™, their subsidiary members of the aforementioned UNIVERSAL POPULACE™ and/or their commission driven account executives, and it is further undeniable and evidentiary, logical, scientific and inutive that simultaneous equality, full transparency, consolidated access and perpetual integration members of the aforementioned UNIVERSAL POPULACE™ with aforementioned fragmenting capital market inefficiencies. Whereas, it is an undeniable and evidentiary findings of fact, documented reference, logical scientific deduction and intuitive analytical reasoning that the recently enacted congressionally promulgated legislative act of congress named the Financial Services Modernization Act of 2000 was subsequently signed into law by President William Clinton on Nov. 12, 1999, thus eliminating every and all barriers to entry which have otherwise for nearly a seventy year period of time, maintained distinctively separate and traditional barrier walls between and among the technique, designs, systems, routines, devices, manners, modes, fashions, forms, formats, factors, objects, parts, segments, elements, components, constituents, ingredients, processes, methods and combinations in which the industries of banking, insurance and securities were capable offering members of the aforementioned UNIVERSAL POPULACE™ access to holistically steady state continuous spectrum ubiquitous indistinguishably synchronous needs involving aforementioned UCMOST™ real-time processing and/or reprocessing of data and/or information content management, financial services and aforementioned PUBLIC FINANCIALS™ instruments transactional exchange initiatives, schemes, ocurrences, happenings, interactions, processes, methods, practices, movements, proceedings, messaging, presentations, notifications, filings, submissions, records, activities, actions, events, endeavors, tasks and affairs. Industry and sector-wide utilization of every and all multivariate techniques, designs, systems, routines, devices, manners, modes, fashions, forms, formats, factors, objects, parts, segments, elements, components, constituents, ingredients, processes, methods and combinations offering members of the aforementioned UNIVERSAL POPULACE™ holistically steady state continuous spectrum ubiquitous indistinguishably synchronous needs involving aforementioned UCMOST™ real-time processing and/or reprocessing of data and/or information content management, financial services and aforementioned PUBLIC FINANCIALS™ instruments transactional exchange initiatives, schemes, ocurrences, happenings, interactions, processes, methods, practices, movements, proceedings, messaging, presentations, notifications, filings, submissions, Modernization Act of 2000 eliminates Glass-Steagall separation of banks, insurance companies, and transactional exchange banking oriented members of the aforementioned UNIVERSAL POPULACE™. Thus, Glass-Steagall barriers are out and a new era of one-stop shop consolidated access to holistically steady state continuous spectrum ubiquitous indistinguishably synchronous needs involving aforementioned UCMOST™ real-time processing and/or reprocessing of data and/or information content management, financial services and aforementioned PUBLIC FINANCIALS™ instruments transactional exchange initiatives, schemes, ocurrences, happenings, interactions, processes, methods, practices, movements, proceedings, messaging, presentations, notifications, filings, submissions, records, activities, actions, events, endeavors, tasks and affairs ensures world-wide massive perpetual integration among the banking, insurance and securities related industry and sectormembers of the aforementioned UNIVERSAL POPULACE™. It is widely recognized that proponents of this newly enacted congressional legislation believe that eliminating these archaic barriers to entry may likely save members of the aforementioned UNIVERSAL POPULACE™ billions of dollars each year by offering greater choices and conveniences to holistically steady state continuous spectrum ubiquitous indistinguishably synchronous needs involving aforementioned UCMOST™ real-time processing and/or reprocessing of data and/or information content management, financial services and aforementioned PUBLIC FINANCIALS™ instruments transactional exchange initiatives, schemes, ocurrences happenings, interactions, processes, methods, practices, movements, proceedings, messaging, presentations, notifications, filings, submissions, records, activities, actions, events, endeavors, tasks and affairs. Furthermore, proponents anticipate that the Financial Service Modernization Act of 2000 may offer the aforementioned fragmenting capital market inefficiencies a competitive edge in the W.W. capital markets in providing holistically steady state continuous spectrum ubiquitous indistinguishably synchronous needs involving aforementioned UCMOST™ real-time processing and/or reprocessing of data and/or information content management, financial services and aforementioned PUBLIC FINANCIALS™ instruments transactional exchange initiatives, schemes, ocurrences, happenings, interactions, processes, methods, practices, movements, UNIVERSAL POPULACE™ from around the world via invoking aforementioned UCMOST™ information technology. Irrespective of what proponents of the Financial Service Modernization Act of 2000 believe, it is an undeniable and evindentiary findings of fact, documented reference, logical scientific deduction and intuitive analystical reasoning that without necessarily addressing nor recognizing the enormously tremendously long-held and enormously heart-felt unmet needs in the relevant art with the novel, unobvious, unique, unknown, unforeseen, unprecedented ease of use and panacean cutting-edge technological innovations via inducement invoked within aforementioned UCMOST™ information technology techniques, designs, systems, devices, processes, parts, segments, methods, combinations, know-how, ideas, art forms, articles of manufacture, discoveries, formulae, and architectural engineering of streamlined procedural computing process design compositions which offer members of the aforementioned UNIVERSAL POPULACE™ groundbreaking and breakthrough utility engineering and architectural design of products and services which offer benefit provisions capable of tempestuous diminishing undeniable, unnecessary, undeniable, unnecessary, unwarranted, illogical, unjustifiable, unreasoned and unmitigated, illogical, unjustifiable and unreasoned tempestuous exponentially detrimental increases in systematic volatility and mitigating tempestuous exponentially debilitating increases in the cost of capital in a single holistically econometric marketplace environment the multifaceted and multidimensional foregoing and herewith referenced legislative acts of congress unequivocally and undeniably fall way short of their aim, letter, nature, spirit, breadth, depth and scope of intent serving the interests members of the aforementioned UNIVERSAL POPULACE™ and every and all members of the aforementioned UNIVERSAL POPULACE™ which endeavor to preclude aforementioned UCMOST™ information technology is irrefutably insolent and unequivocally irresponsible irrespective of whether they are respectively involved in the banking, insurance and securities industries and sectors of a capital market. The aforementioned UCMOST™ information technology unequivocally streamlines and integrates the distinctively separate and traditionally exclusive specialty areas of the efficient, effective, functional and integrated streamlined, alternating scale, inseparable, seamless and natural wrapping, segments, elements, components, constituents, ingredients, processes, methods and combinations of public accounting, transport reconciling, independent auditing and financial reporting inclusive of order-entry quotation, matching, clearance, execution, settlements and exchange of insurance, risk financing, credit, cash management, investment banking and aforementioned PUBLIC FINANCIALS™ instruments which occur, happen and/or transpire anywhere, anytime and anyplace around the world regarless of every and all differentials in culture, languages, regulation and procedures prevelant across the industries and sectors which transcend the boundaris of every and all national sovereign borders of every and all of the industrialized, developed and developing free-market commerce and trade bloc economies of a single holistically econometric marketplace environment wherefrom formation and estalishment of a new theater of operations and higher standards of full disclosure, best practices, best executions, enhanced fairness, simultaneous equality, full transparency, consolidated access and perpetual integration is technologically feasible, commercially viable and undeniably useful to concretize an aforementioned efficient UNIVERSAL CAPITAL MARKET™ in a necessarily integrated, critically important and increasingly integral aforementioned efficient UNIVERSAL ECONOMY™. It is further an undeniable and evidentiary findings of fact, documented reference, logical scientific deduction and intuitive analystical reasoning that aforementioned UCMOST™ information technology recognize, address and resolve, without exception, every and all of the tremendously long-held and enormously heart-felt need in the relevant art and further ensures complete adherence and fully enforceable compliance with every and all techniques, designs, systems, routines, devices, manners, modes, fashions, forms, formats, factors, objects, parts, segments, elements, components, constituents, ingredients, processes, methods and combinations inclusive of every and all applicable laws and congressional statues involving an aforementioned efficient UNIVERSAL CAPITAL MARKET™ which encompass striving for advancements and improvements in the accuracy, quality, integrity, honor, timeliness, relevance, transparency, reliabilty, verifiability, comprehensiveness, understandability and assurance of the efficient, effective, functional and integrated streamlined, alternating scale, inseparable, seamless and natural wrapping, segments, elements, components, constituents, ingredients, processes, methods and combinations entailing, encompassing, comprising, involving, impacting and/or effecting automatizing real-time holistically steady state synchronized ubiquitous continuum real-time rhombus microprocessing instantaneous transmission and receiver transforming traverse conduit aforementioned UCMOST™ real-time processing and/or reprocessing of every and all public accounting, transport reconciling, independent auditing and financial reporting inclusive of efficient, effective, functional and integrated streamlined, alternating scale, inseparable, seamless and natural wrapping, interlacing, coiling, coupling, combining and interlocking techniques, designs, systems, routines, devices, manners, modes, fashions, forms, formats, factors, objects, parts, segments, elements, components, constituents, ingredients, processes, methods and combinations entailing, encompassing, comprising, involving, impacting and/or effecting automatizing real-time holistically steady state synchronized ubiquitous continuum real-time rhombus microprocessing instantaneous transmission and receiver transforming traverse conduit aforementioned UCMOS™ real-time processing and/or reprocessing of every and all order-entry quotation, matching, clearance, execution, settlement and exchange of insurance, risk financing, credit, cash management, investment banking and aforementioned PUBLIC FINANCIALS™ instruments by ensuring fill capacity integral utilization of full disclosure, best practices, best executions, enhanced fairness, simultaneous equality, full transparency, consolidated access and perpetual integration of members members of the aforementioned UNIVERSAL POPULACE™ in every and all basic elemental developments, necessary interactions and integral transactional exchange initiatives, schemes, ocurrences, happenings, interactions, processes, methods, practices, movements, proceedings, messaging, presentations, notifications, filings, submissions, records, activities, actions, events, endeavors, tasks and affairs which in every and all techniques, designs, systems, routines, devices, manners, modes, fashions, forms, formats, factors, objects, parts, segments, elements, components, constituents, ingredients, processes, methods and combinations embody the innate nature and intrinsic scope, breadth, and depth of an aforementioned efficient UNIVERSAL CAPITAL MARKET™ in the worldwide environment. In order to efficiently and effectively and all securities laws, governing rules and authoritative regulations for which the unmet needs in the relevant art pleads for invoking the novel, unobvious, unique, unknown, unforeseen, unprecedented, ease of use and panacean cutting-edge technological innovations in aforementioned UCMOST™ information technology which is furthermore comprehensively suitable, generally pertinent and broadly useful utility and design formulation herewith existent techniques, designs, systems, routines, devices, manners, modes, fashions, forms, formats, factors, objects, parts, segments, elements, components, constituents, ingredients, processes, methods and combinations of reliability, timeliness, efficiency, effectiveness, UNIVERSAL CAPITAL MARKET™ security, and more importantly be fully capable of retrieving, processing, storing, booking, classifying, categorizing, adjusting, altering, revising, changing, charging, billing, collecting, producing, composing, conducting, proofing, filtering, pressing, publishing, cataloging, indexing, posting, compressing, releasing, playing, displaying, broadcasting, distributing and/or syndicating transmission, rebroadcasting, redistributing and/or resyndicating transmission, distributing, and syndicating every and all real-time processing and/or reprocessing of data and/or information receiver from members of the aforementioned UNIVERSAL POPULACE™ in real-time automatizing fashion to provide multivariate utility benefit oriented offerings to members of the aforementioned UNIVERSAL POPULACE™ from around the world encompassing real-time enhanced fairness, simulteanoues equality, full transparency, consolidated access and perpetual integration to every and all techniques, designs, systems, routines, devices, manners, modes, fashions, forms, formats, factors, objects, parts, segments, elements, components, constituents, ingredients, processes, methods and combinations aforementioned PUBLIC FINANCIALS™ statements seamlessly and naturally wrapped, twisted, mixed, convoluted, embroidered and combined in connection with aforementioned PUBLIC FINANCIALS™ instruments from members of the aforementioned UNIVERSAL POPULACE™ real-time fill disclosure, best practices, best executions, enhanced fairness, simulteanoues equality, full transparency, consolidated access and perpetual integration to aforementioned PUBLIC FINANCIALS™ instruments transactional exchange data and PUBLIC FINANCIALS™ transactional exchange instruments non-UNIVERSAL CAPITAL MARKET™ to tens of hundreds of thousands members of the aforementioned UNIVERSAL POPULACE™ and hundreds of millions members of the aforementioned UNIVERSAL POPULACE™ from around the world who each respectively requisite technological solutions to meet their unmet holistically steady state continuous spectrum ubiquitous indistinguishably synchronous needs involving aforementioned UCMOST™ real-time processing and/or reprocessing of data and/or information content management, financial services and aforementioned PUBLIC FINANCIALS™ instruments transactional exchange initiatives, schemes, ocurrences, happenings, interactions, processes, methods, practices, movements, proceedings, messaging, presentations, notifications, filings, submissions, records, activities, actions, events, endeavors, tasks and affairs in a highly dynamic and innately risk oriented marketplace environment in an effort to enable them to protect, sustain, expand and self-manage their treasure accounting, financial fueling and econometric energizing in a marketplace with no respect for the tremendously long-held and enormously heart-felt need in the relevant arts inclusive of the economic and financial interests members of the aforementioned UNIVERSAL POPULACE™. This is intrinsically a findings of fact, knowledge and logical scientific deduction reasoning premised on a comprehensive analysis of enterprise profit driven motives involving the distinctively separate and traditionally exclusive areas of the efficient, effective, functional and integrated streamlined, alternating scale, inseparable, seamless and natural wrapping, interlacing, coiling, coupling, combining and interlocking techniques, designs, systems, routines, devices, manners, modes, fashions, forms, formats, factors, objects, parts, segments, elements, components, constituents, ingredients, processes, methods and combinations entailing, encompassing, comprising, involving, impacting and/or effecting aforementioned UCMOST™ information technology hereto propagating, proclaiming and promulgating a new theater of operations and higher standards of full disclosure, best practices, best executions, enhanced fairness, simultaneous equality, full transparency, consolidated access and perpetual integration of every and all, without limitation, members members of the aforementioned UNIVERSAL POPULACE™ via holistically steady state continuous spectrum ubiquitous indistinguishably synchronous needs FINANCIALS™ instruments transactional exchange initiatives, schemes, ocurrences, happenings, interactions, processes, methods, practices, movements, proceedings, messaging, presentations, notifications, filings, submissions, records, activities, actions, events, endeavors, tasks and affairs by ensuring that necessary advancements and improvements are concretizing via venues and/or mediums involving innovative techniques, designs, systems, devices, processes, parts, segments, methods, combinations, know-how, ideas, art forms, articles of manufacture, discoveries, formulae, and architectural engineering of streamlined procedural computing process design compositions to offer members of the aforementioned UNIVERSAL POPULACE™ breakthrough utility benefit provisions applicable to aforementioned fragmenting capital market inefficiencies by inventing every and all techniques, designs, systems, routines, devices, manners, modes, fashions, forms, formats, factors, objects, parts, segments, elements, components, constituents, ingredients, processes, methods and combinations that involve combinatorial elements, multivariate components, novel features and complex figures which are capable of arriving at the forefront of an aforementioned efficient UNIVERSAL CAPITAL MARKET™ to offer a novel, unobvious, unknown, unforeseen, unprecedented and originally authentic and genuinely melioristic logical positivism resolution to the tremendously long-held and enormously heart-felt unmet needs in the relevant art to hereby facilitate an increased trust and confidence from members of the aforementioned UNIVERSAL POPULACE™ by securing the technological foundation to ensure accuracy, quality, integrity, honor, timeliness, relevance, transparency, comprehensiveness and understandability to every all members of members of the aforementioned UNIVERSAL POPULACE™ which out of their own free will and passions expend their limited time and energy to either offer work driven employment services and/or employed oversight responsibilities over the operational, administrative and management via aforementioned PUBLIC FINANCIALS organizations which are exclusively, undeniably, logically, scientifically and intuitively subservient to effectuating transactional exchange initiatives, schemes, ocurrences, happenings, interactions, processes, methods, practices, movements, proceedings, messaging, presentations, notifications, filings, submissions, records, activities, actions, MARKET™ of a single holistically econometric marketplace environment to earn currency resources to effectively and efficiently implement their strategic competitive missions, goals, plans and objectives within an aforementioned efficient UNIVERSAL CAPITAL MARKET. The aforementioned efficient UNIVERSAL CAPITAL MARKET™ embroiders, embodies, harnesses and leverages every and all industries and sectors within, throughout and transcending a holistically econometric marketplace environment via propagating, proclaiming and promulgating necessary requisites of massive organizational econometric restructuring to facilitate adaptation to a highly competitive and dynamic marketplace heretofore structually and technologically incapable of generating multivariate venues and/or mediums involving innovative techniques, designs, systems, devices, processes, parts, segments, methods, combinations, know-how, ideas, art forms, articles of manufacture, discoveries, formulae, and creating architectural engineering of streamlined procedural computing process design compositions to offer members of the aforementioned UNIVERSAL POPULACE™ breakthrough utility benefit provisions to ensure the cash liqudity, financial solvency and economic stability of the aforementioned efficient UNIVERSAL ECONOMY due to a complete lack of aforementioned UCMOST™ real-time processing and/or reprocessing embroidered, harnessed, leveraged and optimized technically within the aforementioned UCMOST™ information technology to potentially form and establish a new theater of operations premised on strategic long-term planning, fill capacity efficiencies and functional interlocking consolidations ensure the walks of life and livelihoods of hundreds of millions of members of the aforementioned UNIVERSAL POPULACE™ whom requisite technological solutions to meet their unmet needs involving aforementioned UCMOST™ real-time processing and/or reprocessing of data and/or information content management, financial services and aforementioned PUBLIC FINANCIALS™ instruments transactional exchange initiatives, schemes, ocurrences, happenings, interactions, processes, methods, practices, movements, proceedings, messaging, presentations, notifications, filings, submissions, records, activities, actions, events, endeavors, tasks and affairs in a highly dynamic and innately risk oriented marketplace environment in an effort to enable them to protect, sustain, expand and self-need in the relevant arts inclusive of the economic and financial interests of the members of the aforementioned UNIVERSAL POPULACE™. Nonetheless, the enactment of the of the Financial Services Modernization Act of 2000 does represent the most important and formidable recently enacted legal basis and justifiable reasoning for conceiving, engineering and designing innovations that led the sole proprietor independent inventor to the creation of aforementioned UCMOST™ information technology in a self-initiated and self-motivated endeavor in pursuit of potentially assisting members of the aforementioned UNIVERSAL POPULACE™ from around the world by facilitating production of multivariate venues and/or mediums involving innovative techniques, designs, systems, devices, processes, parts, segments, methods, combinations, know-how, ideas, art forms, articles of manufacture, discoveries, formulae, and architectural engineering of streamlined procedural computing process design compositions to offer members of the aforementioned UNIVERSAL POPULACE™ breakthrough utility benefit provisions fully capable of retrieving, processing, storing, booking, classifying, categorizing, adjusting, altering, revising, changing, charging, billing, collecting, producing, composing, conducting, proofing, filtering, pressing, publishing, cataloging, indexing, posting, compressing, releasing, playing, displaying, broadcasting, distributing and/or syndicating transmission, rebroadcasting, redistributing and/or resyndicating transmission, distributing, and syndicating every and all real-time processing and/or reprocessing of data and/or information receiver from public organization in real-time automatizing to provide multivariate utility benefit oriented offerings to members of the aforementioned UNIVERSAL POPULACE™ from around the world encompassing real-time enhanced fairness, simulteanoues equality, full transparency, consolidated access and perpetual integration to every and all techniques, designs, systems, routines, devices, manners, modes, fashions, forms, formats, factors, objects, parts, segments, elements, components, constituents, ingredients, processes, methods and combinations aforementioned PUTBLIC FINANCIALS™ statements seamlessly and naturally wrapped, twisted, mixed, convoluted, embroidered and combined in connection with aforementioned PUBLIC FINANCIALS™ instruments from members of the aforementioned UNIVERSAL POPULACE™ real-time full disclosure, best practices, FINANCIALS™ instruments transactional exchange data and PUBLIC FINANCIALS™ transactional exchange instruments non-financial information to potentially promulgate establishment of a new theater of operations premised on a fully efficient, functional, consolidated, and integrated UNIVERSAL CAPITAL MARKET™. Furthermore, from a legal basis and legislative perspective other congressional acts have also inherently promulgated change to the historical and archaic context in which the present aforementioned fragmenting capital market inefficiencies exist, operate and function on behalf members of the aforementioned UNIVERSAL POPULACE™. The imminent general public understanding of the true innate and intrinsic presence of an aforementioned efficient UNIVERSAL CAPITAL MARKET™ place environment in the world may in time and exclusively premised on various sound legal basis and justification reasoning promulgate implementation of fundamental and detail oriented change across the board within the aforementioned fragmenting capital market inefficiencies inclusive of without limitation, the ancient history and present inefficient, ineffective, dysfunctional and fragmented W.W. capital markets. Two examples of legislative congressional acts which not yet been capable of fully implementing their letter, spirit and nature inclusive of their scope, breadth and depth for potentially effectuating positive enabling change within the aforementioned fragmenting capital market inefficiencies and inefficient, ineffective, dysfunctional and fragmented W.W. capital markets to meet the tremendously long-held and enormously heart-felt need in the relevant art members of the aforementioned UNIVERSAL POPULACE™ concerning holistically steady state continuous spectrum ubiquitous indistinguishably synchronous needs involving aforementioned UCMOST™ real-time processing and/or reprocessing of data and/or information content management, financial services and aforementioned PUBLIC FINANCIALS™ instruments transactional exchange initiatives, schemes, ocurrences, happenings, interactions, processes, methods, practices, movements, proceedings, messaging, presentations, notifications, filings, submissions, records, activities, actions, events, endeavors, tasks and affairs are the National Securities Markets Improvement Act of 1996 and the Private Securities Litigation Reform Act of 1995. The National Securities Markets Improvement Act of 1996 promulgated legislative directive modes, fashions, forms, formats, factors, objects, parts, segments, elements, components, constituents, ingredients, processes, methods and combinations promulgated so-called U.S. legislative leadership for solving the dilemma that engulfs the ancient history and present inefficient, ineffective, dysfunctional and fragmented W.W. capital markets. The requisite legislative mandate of this particular so-called U.S. Congressional act as it pertains to its letter, spirit and nature, inclusive, without limitation, its scope, breadth and depth was to set forth legal basis and justifiable reasoning to establish a single efficient, effective, functional and integrated so-called U.S. capital market from variant incorporation of every and all variant techniques, designs, systems, routines, devices, manners, modes, fashions, forms, formats, factors, objects, parts, segments, elements, components, constituents, ingredients, processes, methods and combinations of multivariate venues and/or mediums involving innovative techniques, designs, systems, devices, processes, parts, segments, methods, combinations, know-how, ideas, art forms, articles of manufacture, discoveries, formulae, and architectural engineering of streamlined procedural computing process design compositions to offer members of the aforementioned UNIVERSAL POPULACE™ breakthrough utility benefit provisions fully capable of retrieving, processing, storing, booking, classifying, categorizing, adjusting, altering, revising, changing, charging, billing, collecting, producing, composing, conducting, proofing, filtering, pressing, publishing, cataloging, indexing, posting, compressing, releasing, playing, displaying, broadcasting, distributing and/or syndicating transmission, rebroadcasting, redistributing and/or resyndicating transmission, distributing, and syndicating every and all real-time processing and/or reprocessing of data and/or information receiver from members of the aforementioned UNIVERSAL POPULACE™ in real-time automatizing to provide multivariate utility benefit oriented offerings to members of the aforementioned UNIVERSAL POPULACE™ from around the world encompassing real-time enhanced fairness, simulteanoues equality, full transparency, consolidated access and perpetual integration to every and all techniques, designs, systems, routines, devices, manners, modes, fashions, forms, formats, factors, objects, parts, segments, elements, components, constituents, ingredients, processes, methods and combinations aforementioned PUBLIC FINANCIALS™ instruments from members of the aforementioned UNIVERSAL POPULACE™ real-time full disclosure, best practices, best executions, enhanced fairness, simulteanoues equality, full transparency, consolidated access and perpetual integration to aforementioned PUBLIC FINANCIALS™ instruments transactional exchange data and PUBLIC FINANCIALS™ transactional exchange instruments non-financial information to potentially promulgate establishment of a new theater of operations premised on a fully efficient, functional, consolidated, and integrated so-called U.S. capital market. The aforementioned fragmenting capital market inefficiencies includes, without limitation, the New York Stock Exchange (NYSE); the National Association of Securities Dealers Automated Quotation (NASDAQ) System, the New York Mercantile Exchange (NYME); the Chicago Mercantile Exchange (CME); the Chicago Board of Options Exchange (CBOE); the Chicago Board of Trade (CBOT); the Philadelphia Stock Exchange (PSE); the American Stock Exchange (ASE); the Over-the-Counter Bulletin Board (OTC-BB); inclusive of, without limitation, multivariate forms of Electronic Communications Networks (ECN's) which heretofore include, without limitation, Archipelago, Attain, Bernard Madoff, Brut, Datek, Instinet, Island, Knight/Trimark, NexTrade, Optimark, Posit, Redibook, Strike, Tradebook, Schwab, Ameritrade and E-Trade. None of the foregoing and aforementioned vast network aforementioned PUBLIC FINANCIALS™ instruments transactional exchange intermediaries have addressed the enormously tremendously long-held and enormously heart-felt need in the relevant art or served the unmet holistically steady state continuous spectrum ubiquitous indistinguishably synchronous needs involving aforementioned UCMOST™ real-time processing and/or reprocessing of data and/or information content management, financial services and aforementioned PUBLIC FINANCIALS™ instruments transactional exchange initiatives, schemes, ocurrences, happenings, interactions, processes, methods, practices, movements, proceedings, messaging, presentations, notifications, filings, submissions, records, activities, actions, events, endeavors, tasks and affairs members of the aforementioned UNIVERSAL POPULACE™ accessing aforementioned fragmenting capital market inefficiencies via substantive unification of their transactional capacities into a single so-called U.S. capital Networks aforementioned PUBLIC FINANCIALS™ instruments transactional exchange intermediaries have addressed an enormously tremendously long-held and enormously heart-felt need in the relevant art for concretizing techniques, designs, systems, routines, devices, manners, modes, fashions, forms, formats, factors, objects, parts, segments, elements, components, constituents, ingredients, processes, methods and combinations of compositions that are intrinsically and integrally twisted, bundled and combinatorial panacean cutting-edge graphical user interfaces, proprietary software programs, software program icons, proprietary operating systems programs, and proprietary operating systems program icons, tailored around innovative techniques, designs, systems, devices, processes, parts, segments, methods, combinations, know-how, ideas, art forms, articles of manufacture, discoveries, formulae, and architectural engineering of streamlined procedural computing process design compositions to offer members of the aforementioned UNIVERSAL POPULACE™ innovative groundbreaking and breakthrough utility engineering and architectural design propagations universal microprocessor computing design provisions to meet their unmet needs within an aforementioned efficient UNIVERSAL CAPITAL MARKET™ which are capable of tempestuous diminishing undeniable, unnecessary, undeniable, unnecessary, unwarranted, illogical, unjustifiable, unreasoned and unmitigated, illogical, unjustifiable and unreasoned tempestuous exponentially detrimental increases in systematic volatility and mitigating tempestuous exponentially debilitating increases in the cost of capital in a single holistically econometric marketplace environment. Whereas, it is an undeniable and evidentiary findings of fact, knowledge and logical scientific deduction reasoning that the large majority of the evolutionary adaptive changes which eventually promulgate positive utility engineering and architectural design propagations universal microprocessor computing design provisional changes within the aforementioned fragmenting capital market inefficiencies are concretizing as innovative twisted and bundled microprocessor computing operating systems, software programs, business methods, and new combinations, pertaining to programmed instruction entailing, encompassing, comprising, involving, impacting and/or effecting every and all one-time programmable read-only memory (PROM) of every and all computing central processing assistants, wireless devices, computing tablets, desktop work-station computers, automated teller machines, digital wall-boards, moving vehicles, airplanes, airplane transport centers, government centers, park, civic center, stadium and/or arenas, hotel bed rooms, entertainment complexes, restaurants, shopping malls, network data centers, etc., further strategically conceived, engineered, designed and developed via contructive reduction to practice to transcend most of the sovereign industrialized, developed and developing nations throughout the world by harnessing the unlimited power of concretizing techniques, designs, systems, routines, devices, manners, modes, fashions, forms, formats, factors, objects, parts, segments, elements, components, constituents, ingredients, processes, methods and combinations of compositions that are intrinsically and integrally twisted, bundled and combinatorial panacean cutting-edge graphical user interfaces, proprietary software programs, software program icons, proprietary operating systems programs, and proprietary operating systems program icons, tailored around innovative techniques, designs, systems, devices, processes, parts, segments, methods, combinations, know-how, ideas, art forms, articles of manufacture, discoveries, formulae, and architectural engineering of streamlined procedural computing process design compositions, inclusive of, without limitation, hardware computing manufacture, artificial satellite wireless and wired communications infrastructure, and network routing capacities to thereof and thereby offer members of the aforementioned UNIVERSAL POPULACE™ the aforementioned efficient UNIVERSAL ECONOMY™ innovative groundbreaking and breakthrough utility engineering and architectural design propagations to concretize establishment of a novel, unobvious, unique, unknown, unforeseen and unprecedented aforementioned efficient UNIVERSAL CAPITAL MARKET™ which realizes an innovative panacean cutting-edge technological bridge oriented digital platform applicable to every and all techniques, designs, systems, routines, devices, manners, modes, fashions, forms, formats, factors, objects, parts, segments, elements, components, constituents, ingredients, processes, methods and combinations of the basic elemental developments, necessary interactions and integral transactional exchange initiatives, schemes, ocurrences, happenings, interactions, processes, methods, practices, movements, proceedings, messaging, presentations, inefficiencies for a necessarily integrated, critically important and increasing integral aforementioned efficient UNIVERSAL ECONOMY™ to ultimately serve the unmet holistically steady state continuous spectrum ubiquitous indistinguishably synchronous needs involving aforementioned UCMOST™ real-time processing and/or reprocessing of data and/or information content management, financial services and aforementioned PUBLIC FINANCIALS™ instruments transactional exchange initiatives, schemes, ocurrences, happenings, interactions, processes, methods, practices, movements, proceedings, messaging, presentations, notifications, filings, submissions, records, activities, actions, events, endeavors, tasks and affairs members of the aforementioned UNIVERSAL POPULACE™. Astonishingly, the distinctively separate and traditionally exclusive banking, insurance and securities industry players have worked diligently to thumb their monetary power and competitive market positions inclusive of widespread utilization of Washington, District of Columbia lobbying efforts and lobbying influences, and thereby flagrantly denounced the letter, spirit and nature of the National Securties Markets Improvements Act of 1996 inclusive of its scope, breadth and depth as a requisite legislative congressional mandate in the so-called U.S. and as a leadership initiative to solve the dilemma encompassing in every and all derivatives techniques, designs, systems, routines, devices, manners, modes, fashions, forms, formats, factors, objects, parts, segments, elements, components, constituents, ingredients, processes, methods and combinations the ancient history and present inefficient, ineffective, dysfunctional and fragmented W.W. capital markets. This so-called U.S. traditional competitive marketplace environment has henceforth from the date of the enactment of the National Securities Market Improvement Act of 1996 failed to uphold the letter, intent and nature inclusive of the scope, breadth and depth of what the so-called U.S. Congress explicitly stipulated and legislatively mandated was deemed necessary to offer low-cost effective benefits and high-end efficient capabilities to members of the aforementioned UNIVERSAL POPULACE™ to ensure that full disclosure, best practices, best executions, enhanced fairness, simultaneous equality, full transparency, consolidated access and perpetual integration of members members of the aforementioned UNIVERSAL POPULACE™ are established as the norm and premise members of the aforementioned UNIVERSAL POPULACE™ within the aforementioned fragmenting capital market inefficiencies and in derivative forms via so-called U.S. legislative leadership in the W.W. capital markets in their respective pursuits of protection, sustenance and expansion of their treasure accounting, financial fueling and econometric energizing in a highly dynamic and innately risk oriented marketplace environment. Prior to enactment of the National Securities Market Improvement Act of 1996, their has been no concrete and effective legal basis and justifiable reasoning in the so-called U.S. for full capacity integrated actualization of pursuit of legislative basis and justifiable reasoning promulgating solutions applicable to the vast networks of antiquated, archaic, ancient history and superannuated aforementioned PUBLIC FINANCIALS™ organizations encompassing the inefficient, ineffective, dysfunctional and fragmented competitive market forces with aforementioned fragmenting capital market inefficiencies. Yet another example of legislative movement toward fundamental and detail oriented positive enabling change applicable to the aforementioned fragmenting capital market inefficiencies and via derivative legislative leadership to the ancient history and present inefficient, ineffective, dysfunctional and fragmented W.W. capital markets is the Private Securities Litigation Reform Act of 1995 whose congressional letter, spirit and nature inclusive of, without limitation, its scope, breadth and depth pursues the highest form of assurance and protection to members of the aforementioned UNIVERSAL POPULACE™ whichever every and all are furthermore undeniably, logically, scientifically and intuitively deduced, apprehended and invoked as necessarily integrated, critically important and increasingly integral members of the aforementioned UNIVERSAL POPULACE™ who necessarily, directly and indirectly, participate in and have a large stake with aforementioned fragmenting capital market inefficiencies. The Private Securities Litigation Reform Act of 1995 is a legislative congressional act that innately and instrincally immunizes, protects and precludes the senior executives members of the aforementioned UNIVERSAL POPULACE™ from illegitimate, frivolous, fabricated, misconstrued, phony, hoaxed, bogus and/or unsubstantiated lawsuits entailing, encompassing, comprising, involving, impacting and/or effecting every and all members of the aforementioned UNIVERSAL social, jealous, vengeful, unethical, immoral, irreligious, unashamed, unscrupulous, unaccountable, uncomprehending, unfamiliar, unlettered, ignorant, untrained, unskilled, frigid, ruthless, distressed, distraught, disingenuous, disavowed, disbelieving, perverted and ultimately every and all techniques, designs, systems, routines, devices, manners, modes, fashions, forms, formats, factors, objects, parts, segments, elements, components, constituents, ingredients, processes, methods and combinations of expectations, anticipations, aspirations, hopes, wishes and desires conceived out of greed from members of the aforementioned UNIVERSAL POPULACE™ whichever every and all are furthermore undeniably, logically, scientifically and intuitively deduced, apprehended and invoked as necessarily integrated, critically important and increasingly integral members of the aforementioned UNIVERSAL POPULACE™ promulgated as individual beings and/or via class-action status whether or not ascertained commercially, personally and/or via assistance and/or guidance from legal counsel representatives based on the dissemination of forward-looking aforementioned PUBLIC FINANCIALS™ statements inclusive of seamlessly and naturally wrapped, twisted, mixed, convoluted, embroidered and combined in connection with aforementioned PUBLIC FINANCIALS™ instruments from senior executives members of the aforementioned UNIVERSAL POPULACE™ premised exclusively on the members of the aforementioned UNIVERSAL POPULACE™ operations, transactional exchanges and financing initiatives, schemes, ocurrences, happenings, interactions, processes, methods, practices, movements, proceedings, messaging, presentations, notifications, filings, submissions, records, activities, actions, events, endeavors, tasks and affairs. The Private Securities Litigation Reform Act of 1995 innately sets forth a safe harbor immunization, protection and preclusion for senior executives members of the aforementioned UNIVERSAL POPULACE™ from the aforementioned by inversely mandating requisite obstacles that must be surpassed before any from of civil lawsuit against a senior executive of the members of the aforementioned UNIVERSAL POPULACE™ and/or members of the aforementioned UNIVERSAL POPULACE™ deemed a defendant to said legal action is enabled to bypass summary judgement on behalf of the senior executives and members of the aforementioned UNIVERSAL POPULACE™ pertaining to every and all techniques, methods and combinations of legal actions premised on booking, classifying, categorizing, adjusting, altering, revising, changing, charging, billing, collecting, producing, composing, conducting, proofing, filtering, pressing, publishing, cataloging, indexing, posting, compressing, releasing, playing, displaying, broadcasting, distributing and/or syndicating transmission, rebroadcasting, redistributing and/or resyndicating transmission and/or distributing every and all techniques, designs, systems, routines, devices, manners, modes, fashions, forms, formats, factors, objects, parts, segments, elements, components, constituents, ingredients, processes, methods and combinations of forward-looking aforementioned PUBLIC FINANCIALS™ statements inclusive of seamlessly and naturally wrapped, twisted, mixed, convoluted, embroidered and combined in connection with aforementioned PUBLIC FINANCIALS™ instruments to the stakeholders and members of the aforementioned UNIVERSAL POPULACE™. The innately integrated and intrinsically integral safe harbor immunization, protection and preclusion afforded to senior executives and public organization under the Private Securities Litigation Reform Act of 1995 concerns every and all forward-looking statements and further applies to every and all related statements made by senior executives and members of the aforementioned UNIVERSAL POPULACE™ which are not historical financial and non-financial records and/or performance results, thus subjecting every and all such forward-looking statement to immunization, protection and preclusion from from illegitimate, frivolous, fabricated, misconstrued, phony, hoaxed, bogus and/or unsubstantiated lawsuits entailing, encompassing, comprising, involving, impacting and/or effecting every and all members of the aforementioned UNIVERSAL POPULACE™ civil and/or criminal legal claims, declarations, proceeedings, arbitrations and/or mediations brought before a court of law in the so-called U.S. against senior executives members of the aforementioned UNIVERSAL POPULACE™ by members of the aforementioned UNIVERSAL POPULACE™ exclusively as individual beings and/or via ascertained assistance from legal counsel representatives who have thus far in an usually unsubstantiated techniques, designs, systems, routines, devices, manners, modes, fashions, forms, formats, factors, objects, parts, segments, elements, components, constituents, ingredients, processes, methods and combinations and in direct contrast to equity and/or bond debt PUBLIC FINANCIALS™ instruments, and which thereupon subsequently pursued legal damages and relief from senior executives and theirmembers of the aforementioned UNIVERSAL POPULACE™ claiming their transactional exchange decisions and resulting losses derived directly and/or indirectly from forward-looking statements made by the senior executives and theirmembers of the aforementioned UNIVERSAL POPULACE™. The Private Securities Litigation Reform Act of 1995 enacted an important safe harbor immunization, protection and preclusion for senior executives with respect to disclosure of forward-looking statement, and this penal, statutory safe harbor immunization, protection and preclusion from class-action and/or individual filed lawsuits initiated by members of the aforementioned UNIVERSAL POPULACE™ and/or via legal counsel representatives applies to every disclosure other than those contained in PUBLIC FINANCIALS™ statements prepared in accordance with generally accepted accounting principles or made in combination with certain types aforementioned PUBLIC FINANCIALS™ instruments offerings. Because senior executives are now protected from civil lawsuits filed by members of the aforementioned UNIVERSAL POPULACE™ and/or via legal counsel representatives, it seems inconsistent and irrational that the senior executives and members of the aforementioned UNIVERSAL POPULACE™ would completely disregard the utility benefits offered to members of the aforementioned UNIVERSAL POPULACE™ in harnessing the unlimited power of concretizing techniques, designs, systems, routines, devices, manners, modes, fashions, forms, formats, factors, objects, parts, segments, elements, components, constituents, ingredients, processes, methods and combinations of compositions that are intrinsically and integrally twisted, bundled and combinatorial panacean cutting-edge graphical user interfaces, proprietary software programs, software program icons, proprietary operating systems programs, and proprietary operating systems program icons, tailored around innovative techniques, designs, systems, devices, processes, parts, segments, methods, combinations, know-how, ideas, art forms, articles of manufacture, discoveries, formulae, and architectural engineering of streamlined procedural computing process design compositions, inclusive of; without limitation, hardware computing manufacture, artificial satellite wireless and wired communications UNIVERSAL ECONOMY™ innovative groundbreaking and breakthrough utility engineering and architectural design propagations to concretize establishment of a novel, unobvious, unique, unknown, unforeseen and unprecedented aforementioned efficient UNIVERSAL CAPITAL MARKET™ which realizes an innovative panacean cutting-edge technological bridge oriented digital platform applicable to every and all techniques, designs, systems, routines, devices, manners, modes, fashions, forms, formats, factors, objects, parts, segments, elements, components, constituents, ingredients, processes, methods and combinations of the basic elemental developments, necessary interactions and integral transactional exchange initiatives, schemes, ocurrences, happenings, interactions, processes, methods, practices, movements, proceedings, messagig, presentations, notifications, filings, submissions, records, activities, actions, events, endeavors, tasks and affairs found prevalent with aforementioned fragmenting capital market inefficiencies for a necessarily integrated, critically important and increasing integral aforementioned efficient UNIVERSAL ECONOMY™. Further legal basis and justifiable reasoning for the utility benefits and commercial salability aforementioned UCMOST™ information technology within the aforementioned fragmenting capital market inefficiencies is evinced in legislative congressional actions which date back in history to include, without limitation, the Transactional exchange Advisors Act of 1970 which governs registration with the so-called U.S. SEC of every and all such professionals who actively participate as specialists and consultants offering their services to institutional level members of the aforementioned UNIVERSAL POPULACE™ pertaining to advice provided in regards to historical UNIVERSAL CAPITAL MARKET™ performance and effectuating development, management and transactional exchange aforementioned PUBLIC FINANCIALS™ instruments transactional exchange decision initiatives, schemes, ocurrences, happenings, interactions, processes, methods, practices, movements, proceedings, messaging, presentations, notifications, filings, submissions, records, activities, actions, events, endeavors, tasks and affairs, and the Transactional exchange Company Act of 1940 which governs registrations with the so-called U.S. SEC of every and all transactional exchange companies involved in offering passive and/or automatizing development, POPULACE™ via direct marketing efforts and/or via the vast network members of the aforementioned UNIVERSAL POPULACE™ involved in the heretofore inefficient, ineffective, dysfunctional and fragmented barriers to entry within the aforementioned fragmenting capital market inefficiencies inclusive of, without limitation, varying multifaceted and multidimensional historical so-called U.S. securities laws, governing rules and authoritative regulations to pursue complete steadfast adherence and fully enforceable compliance with the so-called U.S. Securities Act of 1933 and the so-called U.S. Securities Exchange Act of 1934. Although these legislative acts of so-called U.S. Congress are limited in presentation hereto given the on-going developments involving the aforementioned fragmenting capital market inefficiencies they inherently represent a few of the most powerful legal shields available to protect the interests members of the aforementioned UNIVERSAL POPULACE™ accessing the aforementioned fragmenting capital market inefficiencies, thus enabling members of the aforementioned UNIVERSAL POPULACE™ to receive more timely, reliable and secure access to a so-called U.S. capital market that innately promulgates liquidity, transparency and efficiencies in every and all basic elemental developments, necessary interactions and integral transactional exchange initiatives, schemes, ocurrences, happenings, interactions, processes, methods, practices, movements, proceedings, messaging, presentations, notifications, filings, submissions, records, activities, actions, events, endeavors, tasks and affairs to pursue establishment of a high-quality UNIVERSAL CAPITAL MARKET™. It is basic intuitive knowledge and sophisticated logic processes which lead intelligent beings to consider the importance on offering members of the aforementioned UNIVERSAL POPULACE™ who access the aforementioned fragmenting capital market inefficiencies enhanced fairness, simulteanoues equality, full transparency, consolidated access and perpetual integration to holistically steady state continuous spectrum ubiquitous indistinguishably synchronous needs involving aforementioned UCMOST™ real-time processing and/or reprocessing of data and/or information content management, financial services and aforementioned PUBLIC FINANCIALS™ instruments transactional exchange initiatives, schemes, ocurrences, happenings, interactions, processes, methods, practices, movements, proceedings, passive development, management and transactional exchange transactional execution to ensure each of these members of the aforementioned UNIVERSAL POPULACE™ whichever every and all are furthermore undeniably, logically, scientifically and intuitively deduced, apprehended and invoked as necessarily integrated, critically important and increasingly integral members of the aforementioned UNIVERSAL POPULACE™ are capable of effectuating efficient, effective, streamlined, objective, well-informed, risk-managed and self-assured aforementioned PUBLIC FINANCIALS™ instruments transactional exchange decision initiatives, schemes, ocurrences, happenings, interactions, processes, methods, practices, movements, proceedings, messaging, presentations, notifications, filings, submissions, records, activities, actions, events, endeavors, tasks and affairs in pursuit of protection, sustenance and expansion of their treasure accounting, financial fueling and econometric energizing in a highly dynamic and integral marketplace environment which by definition is enthralled, engulfed and oppressed of every and all techniques, designs, systems, routines, devices, manners, modes, fashions, forms, formats, factors, objects, parts, segments, elements, components, constituents, ingredients, processes, methods and combinations of risk oriented uncertainty are comprehensively suitable, generally pertinent and broadly useful to the performance and profitability inherent to members of the aforementioned UNIVERSAL POPULACE™ and which thereupon the valuation applicable to the aforementioned PUBLIC FINANCIALS™ instruments registered, listed and exchange within the aforementioned fragmenting capital market inefficiencies. Neither of the foregoing and aforementioned legislative acts of so-called U.S. Congress nor the present unmet needs members of the aforementioned UNIVERSAL POPULACE™ applicable to concretizing techniques, designs, systems, routines, devices, manners, modes, fashions, forms, formats, factors, objects, parts, segments, elements, components, constituents, ingredients, processes, methods and combinations of compositions invoked within aforementioned UCMOST™ information technology to thereof and thereby offer members of the aforementioned UNIVERSAL POPULACE™ an aforementioned efficient UNIVERSAL CAPITAL MARKET™ for a necessarily integrated, critically important and increasing integral aforementioned efficient UNIVERSAL ECONOMY™ unforeseen and unprecedented aforementioned efficient UNIVERSAL CAPITAL MARKET™ which realizes an innovative panacean cutting-edge technological bridge oriented digital platform applicable to every and all techniques, designs, systems, routines, devices, manners, modes, fashions, forms, formats, factors, objects, parts, segments, elements, components, constituents, ingredients, processes, methods and combinations of the basic elemental developments, necessary interactions and integral transactional exchange initiatives, schemes, ocurrences, happenings, interactions, processes, methods, practices, movements, proceedings, messaging, presentations, notifications, filings, submissions, records, activities, actions, events, endeavors, tasks and affairs found prevalent with aforementioned fragmenting capital market inefficiencies for a necessarily integrated, critically important and increasing integral aforementioned efficient UNIVERSAL ECONOMY™ having recognized and addressed to completely resolve every and all of the enormously tremendously long-held and enormously heart-felt need in the relevant arts as a useful solution for the benefit members of the aforementioned UNIVERSAL POPULACE™ regarding their imminent requisite functions of effectuating development, management and transactional exchange decisions via use of holistically steady state continuous spectrum ubiquitous indistinguishably synchronous needs involving aforementioned UCMOST™ real-time processing and/or reprocessing of data and/or information content management, financial services and aforementioned PUBLIC FINANCIALS™ instruments transactional exchange initiatives, schemes, ocurrences, happenings, interactions, processes, methods, practices, movements, proceedings, messaging, presentations, notifications, filings, submissions, records, activities, actions, events, endeavors, tasks and affairs. Nevertheless, these various so-called U.S. leadership oriented congressional acts have set forth a sound legal basis and justifiable reasoning for promulgating such concretizing techniques, designs, systems, routines, devices, manners, modes, fashions, forms, formats, factors, objects, parts, segments, elements, components, constituents, ingredients, processes, methods and combinations of compositions that are intrinsically and integrally twisted, bundled and combinatorial panacean cuffing-edge graphical user interfaces, proprietary software programs, software program icons, proprietary operating combinations, know-how, ideas, art forms, articles of manufacture, discoveries, formulae, and architectural engineering of streamlined procedural computing process design compositions, inclusive of, without limitation, hardware computing manufacture, artificial satellite wireless and wired communications infrastructure, and network routing capacities to thereof and thereby offer members of the aforementioned UNIVERSAL POPULACE™ the aforementioned efficient UNIVERSAL ECONOMY™ innovative groundbreaking and breakthrough utility engineering and architectural design propagations to concretize establishment of a novel, unobvious, unique, unknown, unforeseen and unprecedented aforementioned efficient UNIVERSAL CAPITAL MARKET™ which realizes an innovative panacean cutting-edge technological bridge oriented digital platform applicable to every and all techniques, designs, systems, routines, devices, manners, modes, fashions, forms, formats, factors, objects, parts, segments, elements, components, constituents, ingredients, processes, methods and combinations of the basic elemental developments, necessary interactions and integral transactional exchange initiatives, schemes, ocurrences, happenings, interactions, processes, methods, practices, movements, proceedings, messaging, presentations, notifications, filings, submissions, records, activities, actions, events, endeavors, tasks and affairs found prevalent with aforementioned fragmenting capital market inefficiencies for a necessarily integrated, critically important and increasing integral aforementioned efficient UNIVERSAL ECONOMY™ via complete adherence and fully enforceable requisite legislative congressional acts promulgating offering members of the aforementioned UNIVERSAL POPULACE™ full disclosure, best practices, best executions, enhanced fairness, simulteanoues equality, full transparency, consolidated access and perpetual integration related to automatizing real-time holistically steady state synchronized ubiquitous continuous uptime real-time automatizing real-time transmission propagating transporting transmuting partible beta particle beam gliding transponder converting receiver conduit aforementioned UCMOST™ real-time processing and/or reprocessing via emboidering, leveraging and harnessing the aforementioned UCMOST™ information technology to hereby proclaim and promulgate the infinitely necessary aforementioned efficient UNIVERSAL CAPITAL MARKET™ UNIVERSAL CAPITAL MARKET™ communication propagating the heretofore conceptual aids which heretofore innovatively and technically are undeniably, logically, scientifically and intuitively completely and comprehensively unsuitable, generally insolent and broadly unacceptable traversing aforementioned PUBLIC FINANCIALS™ statements distinctively separate and traditionally exclusive from aforementioned PUBLIC FINANCIALS™ instruments from members of the aforementioned UNIVERSAL POPULACE™ which otherwise recognized, addressed and completely resolved wherefrom hereto invoked within aforementioned UCMOST™ information technology concretizes comprehensively suitably, generally pertinent and broadly useful public accounting, transport reconciling, independent auditing and financial reporting to propagating full disclosure, best practices, best executions, enhanced fairness, simulteanoues equality, full transparency, consolidated access and perpetual integration to automating real-time holistically steady state synchronized ubiquitous continuous uptime real-time automatizing real-time holistically steady state synchronized ubiquitous continuous uptime real-time automatizing real-time transmission propagating transporting transmuting partible beta particle beam gliding transponder converting receiver conduit which pleads for invoked within aforementioned UCMOST™ information technology which innately and intrinsically concretizes a comprehensively suitable, generally pertient and broadly useful resolution to all of the tremendously long-held and enormously heart-felt unmet neeeds in the relevant art.

5. Public Capital Market Regulation

It is a widely recognized and acknowledged evidentiary findings of fact that every and all techniques, designs, systems, routines, devices, manners, modes, fashions, forms, formats, factors, objects, parts, segments, elements, components, constituents, ingredients, processes, methods and combinations of PUBLIC FINANCIALS™ statements from members of the aforementioned UNIVERSAL POPULACE™ are the cornerstone of a liquid, transparent and efficient UNIVERSAL CAPITAL MARKET™. Moreover, the accuracy, quality, integrity, honor, timeliness, relevance, transparency, offered to members of the aforementioned UNIVERSAL POPULACE™ is the lifeblood of a strong, vibrant and expanding aforementioned efficient UNIVERSAL CAPITAL MARKET™. The lifeblood of an aforementioned efficient UNIVERSAL CAPITAL MARKET™ encompasses the specialty areas of the efficient, effective, functional and integrated streamlined, alternating scale, inseparable, seamless and natural wrapping, interlacing, coiling, coupling, combining and interlocking techniques, designs, systems, routines, devices, manners, modes, fashions, forms, formats, factors, objects, parts, segments, elements, components, constituents, ingredients, processes, methods and combinations entailing, encompassing, comprising, involving, impacting and/or effecting all public accounting, transport reconciling, independent auditing and financial reporting inclusive of, without limitation, the efficient, effective, functional and integrated streamlined, alternating scale, inseparable, seamless and natural wrapping, interlacing, coiling, coupling, combining and interlocking techniques, designs, systems, routines, devices, manners, modes, fashions, forms, formats, factors, objects, parts, segments, elements, components, constituents, ingredients, processes, methods and combinations entailing, encompassing, comprising, involving, impacting and/or effecting all order-entry quotation, matching, clearance, execution, settlement and exchange of insurance, risk financing, credit, cash management, investment banking, and PUBLIC FINANCIALS™ instruments transactional activities. These pertinent specialty fields involved within the aforementioned fragmenting capital market inefficiencies are historically distinctively separate and traditionally exclusive areas which are considered in every and all techniques, designs, systems, routines, devices, manners, modes, fashions, forms, formats, factors, objects, parts, segments, elements, components, constituents, ingredients, processes, methods and combinations the basic elemental developments, necessary interactions and integral transactional exchange initiatives, schemes, ocurrences, happenings, interactions, processes, methods, practices, movements, proceedings, messaging, presentations, notifications, filings, submissions, records, activities, actions, events, endeavors, tasks and affairs found prevalent within an aforementioned efficient UNIVERSAL CAPITAL MARKET™. The fundamentals of the accounting and finance profession which are the core of the basic elemental movements, proceedings, messaging, presentations, notifications, filings, submissions, records, activities, actions, events, endeavors, tasks and affairs within an aforementioned efficient UNIVERSAL CAPITAL MARKET™ are premised on reporting accurate, timely, reliable and verifiable every and all real-time processing and/or reprocessing of data and/or information receiver on present and future economic resources, financial transactions, operational occurrences, recurring events, miscellaneous items, and cost or expense driven initiatives, schemes, ocurrences, happenings, interactions, processes, methods, practices, movements, proceedings, messaging, presentations, notifications, filings, submissions, records, activities, actions, events, endeavors, tasks and affairs, and more specifically, forecasting the present values of future cash flows, earnings, taxes, profits and intangible valuations of members of the aforementioned UNIVERSAL POPULACE™ and are therein leveraged to adequately forecast the underlying aforementioned PUBLIC FINANCIALS™ instruments of a public organization available to members of the aforementioned UNIVERSAL POPULACE™ to seamlessly and naturally business and transactional exchange decisions. The every and all techniques, designs, systems, routines, devices, manners, modes, fashions, forms, formats, factors, objects, parts, segments, elements, components, constituents, ingredients, processes, methods and combinations aforementioned PUBLIC FINANCIALS™ statements seamlessly and naturally wrapped, twisted, mixed, convoluted, embroidered and combined in connection with aforementioned PUBLIC FINANCIALS™ instruments from members of the aforementioned UNIVERSAL POPULACE™ comprise the bulk of every and all real-time processing and/or reprocessing of data and/or information receiver on present and future economic resources, financial transactions, operational occurrences, recurring events, miscellaneous items, and cost or expense driven initiatives, schemes, ocurrences, happenings, interactions, processes, methods, practices, movements, proceedings, messaging, presentations, notifications, filings, submissions, records, activities, actions, events, endeavors, tasks and affairs compiled, formatted, and disclosed to shareholders, depositors, constituencies, creditors and members of the aforementioned UNIVERSAL POPULACE™, affording a moment in time snapshot picture of the present and potential future operational, financial and transactional exchange position, classifying, categorizing, adjusting altering, revising, changing, charging, billing, collecting, producing, composing, conducting, proofing, filtering, pressing, publishing, cataloging, indexing, posting, compressing, releasing, playing, displaying, broadcasting, distributing and/or syndicating transmission, rebroadcasting, redistributing and/or resyndicating transmission, distributing and syndicating every and all techniques, designs, systems, routines, devices, manners, modes, fashions, forms, formats, factors, objects, parts, segments, elements, components, constituents, ingredients, processes, methods and combinations aforementioned PUBLIC FINANCIALS™ statements seamlessly and naturally wrapped, twisted, mixed, convoluted, embroidered and combined in connection with aforementioned PUBLIC FINANCIALS™ instruments from members of the aforementioned UNIVERSAL POPULACE™ is to evaluate the organizations capacity to meet every and all present and future claims, obligations and responsibilities given its present and future economic resources, financial transactions, operational occurrences, recurring events, miscellaneous items, and cost or expense driven initiatives, schemes, ocurrences, happenings, interactions, processes, methods, practices, movements, proceedings, messaging, presentations, notifications, filings, submissions, records, activities, actions, events, endeavors, tasks and affairs. Moreover, every and all techniques, designs, systems, routines, devices, manners, modes, fashions, forms, formats, factors, objects, parts, segments, elements, components, constituents, ingredients, processes, methods and combinations aforementioned PUBLIC FINANCIALS™ statements seamlessly and naturally wrapped, twisted, mixed, convoluted, embroidered and combined in connection with aforementioned PUBLIC FINANCIALS™ instruments from members of the aforementioned UNIVERSAL POPULACE™ are further utilized to measure the performance of management's stewardship of these economic and financial resources leveraged by senior executives to carry out and executive their strategic competitive enterprise plans for the marketplace. The so-called U.S. SEC is logically responsible via its vested legal charter with the independent governing power and regulatory authority over the aforementioned fragmenting capital market inefficiencies and ensuring for the benefit members of the aforementioned UNIVERSAL POPULACE™ the highest degree of assurance transparency, reliabilty, verifiability, comprehensiveness, understandability and assurance of the aforementioned PUBLIC FINANCIALS™ statements inclusive of seamlessly and naturally wrapped, twisted, mixed, convoluted, embroidered and combined in connection with aforementioned PUBLIC FINANCIALS™ instruments reported by members of the aforementioned UNIVERSAL POPULACE™ inclusive of, without limitation, every and all aforementioned PUBLIC FINANCIALS™ instruments transactional exchange data with aforementioned PUBLIC FINANCIALS™ instruments transactional exchange information. In reaffirming the foregoing and aforementioned, it is a theorem of the sole proprietor and independent inventor of aforementioned UCMOST™ information technology that premised on its innate and intrinsic proprietary operating systems capabilities, inclusive of, without limitation, documented evidentiary knowledge and understanding of basic functional elements and integrally seamlessly integrated transactional exchange initiatives involved within an aforementioned efficient UNIVERSAL CAPITAL MARKET™, that the aforementioned fragmenting capital market inefficiencies should explicitly and perpetually be regulated as an holistically steady state continuous spectrum ubiquitous indistinguishably synchronous needs involving aforementioned UCMOST™ real-time processing and/or reprocessing of data and/or information content management, financial services and aforementioned PUBLIC FINANCIALS™ instruments transactional exchange initiatives, schemes, ocurrences, happenings, interactions, processes, methods, practices, movements, proceedings, messaging, presentations, notifications, filings, submissions, records, activities, actions, events, endeavors, tasks and affairs marketplace and therein exclusively by the so-called U.S. SEC as a single national system in accordance with its vest legal charter and independent governing power and regulatory authority. The so-called U.S. SEC's vested legal charter and independent governing power and regulatory authority ensures its responsibility to regulate and oversee the so-called U.S. Securities Act of 1933 which governs the initial distribution of public organization equity and debt UNIVERSAL CAPITAL MARKET™ security issues. The so-called U.S. Securities Act of 1933 requires a public organization to register their aforementioned PUBLIC FINANCIALS™ instruments and make full disclosure of their aforementioned PUBLIC FINANCIALS™ FINANCIALS™ instruments before their aforementioned PUBLIC FINANCIALS™ instruments can be offered to members of the aforementioned UNIVERSAL POPULACE™. The so-called U.S. SEC's vested legal charter and independent governing power and regulatory authority ensures its responsibility to regulate and oversee the so-called U.S. Securities Exchange Act of 1934 which requires periodic updating of every and all techniques, designs, systems, routines, devices, manners, modes, fashions, forms, formats, factors, objects, parts, segments, elements, components, constituents, ingredients, processes, methods and combinations aforementioned PUBLIC FINANCIALS™ statements seamlessly and naturally wrapped, twisted, mixed, convoluted, embroidered and combined in connection with aforementioned PUBLIC FINANCIALS™ instruments from members of the aforementioned UNIVERSAL POPULACE™ whose aforementioned PUBLIC FINANCIALS™ instruments are registered and subsequently listed on a free-marketplace licensed so-called U.S. Securities Exchange, such as the present NYSE and NASDAQ inclusive of, without limitation, various ECN's. The so-called U.S. Securities Exchange Act of 1934 devised the vested legal charter and ensured the independent governing power and regulatory authority of the so-called U.S. Securities and Exchange Commission (SEC) assigning exclusively to it, as a specially designated independent agency of the so-called U.S. federal government, the highest degree of responsibility in administering both the so-called U.S. Securities Act of 1933 and the so-called U.S. Securities Exchange Act of 1934. The so-called U.S. SEC has vested in its legal charter the sole responsibility of upholding the so-called U.S. securities laws, promulgating every and all rules and regulations, and furthermore fully enforcing such applicable securities laws, governing rules and authoritative regulations which govern over the aforementioned fragmenting capital market inefficiencies and further involve every and all holistically steady state continuous spectrum ubiquitous indistinguishably synchronous needs involving aforementioned UCMOST™ real-time processing and/or reprocessing of data and/or information content management, financial services and aforementioned PUBLIC FINANCIALS™ instruments transactional exchange initiatives, schemes, ocurrences, happenings, interactions, processes, methods, practices, movements, proceedings, inefficiencies inclusive of every and all obscurant, irresponsible, feculent, irrational, feckless, disrespectful, mendacious, ignorant, malicious, condescending, untruthful, insolent, inefficient, incognizant, ineffective, fragmenting, unlettered, unpolished, presumptuous, portentous, pretentious, fruitless, disparate, antiquated, archaic, ancient history and superannuated so-called U.S. territories and copious works with transnational governing bodies and sovereign national economies to promulgate multinational governing power and authority. The so-called U.S. SEC also has the vested independent regulatory power and governing authority to determine the aforementioned PUBLIC FINANCIALS™ statements inclusive of seamlessly and naturally wrapped, twisted, mixed, convoluted, embroidered and combined in connection with aforementioned PUBLIC FINANCIALS™ instruments disclosures that a public organization registering aforementioned PUBLIC FINANCIALS™ instruments and listing them on a so-called U.S. securities exchange must make to it as an independent regulatory authority and herewith members of the aforementioned UNIVERSAL POPULACE™ . It is a theorem of the sole proprietor independent depositor of aforementioned UCMOST™ information technology premised on vested legal charter and independent power over the aforementioned fragmenting capital market inefficiencies that the so-called U.S. SEC is the ultimate governing authority of the aforementioned fragmenting capital market inefficiencies. Moreover, its exclusively held independent regulatory power overshadows every and all other independent agencies who may, directly or indirectly, be involved in oversight responsibility of varying industries and sectors which necessarily participate within the aforementioned fragmenting capital market inefficiencies. The so-called U.S. Securities Act of 1933 and the so-called U.S. Securities Exchange Act of 1934 in combination requires fill disclosure from members of the aforementioned UNIVERSAL POPULACE™ as a premise of their initial registration aforementioned PUBLIC FINANCIALS™ instruments, subsequent distribution of their PUBLIC FINANCIALS™ instruments, eventual syndication aforementioned PUBLIC FINANCIALS™ instruments inclusive of, without limitation, the continual listing aforementioned PUBLIC FINANCIALS™ instruments on a licensed so-called U.S. Securities Exchange. It is evident that at the time of its initiation the so-called U.S. SEC pertinent to measurement, reporting and auditing to fully promulgate its vested legal charter and independent governing power and regulatory authority to assure so-called U.S. and members of the aforementioned UNIVERSAL POPULACE™ of full disclosure aforementioned PUBLIC FINANCIALS™ statements inclusive of seamlessly and naturally wrapped, twisted, mixed, convoluted, embroidered and combined in connection with aforementioned PUBLIC FINANCIALS™ instruments requited from members of the aforementioned UNIVERSAL POPULACE™ inclusive of, without limitation, fully capacity utilization of best practices and best executions of every and all techniques, designs, systems, routines, devices, manners, modes, fashions, forms, formats, factors, objects, parts, segments, elements, components, constituents, ingredients, processes, methods and combinations of factual holistically steady state continuous spectrum ubiquitous indistinguishably synchronous needs involving aforementioned UCMOST™ real-time processing and/or reprocessing of data and/or information content management, financial services and aforementioned PUBLIC FINANCIALS™ instruments transactional exchange initiatives, schemes, ocurrences, happenings, interactions, processes, methods, practices, movements, proceedings, messaging, presentations, notifications, filings, submissions, records, activities, actions, events, endeavors, tasks and affairs in every and all obscurant, irresponsible, feculent, irrational, feckless, disrespectful, mendacious, ignorant, malicious, condescending, untruthful, insolent, inefficient, incognizant, ineffective, fragmenting, unlettered, unpolished, presumptuous, portentous, pretentious, fruitless, disparate, antiquated, archaic, ancient history and superannuated so-called U.S. territories involving every and all aforementioned PUBLIC FINANCIALS™ instruments, henceforth aforementioned UCMOST™ information technology. In compromise premised on its subtle beginnings, the so-called U.S. SEC passively relegated its vested legal charter and independent governing power and regulatory authority to facilitate a positive enabling working relationship with the distinctively separate and traditionally exclusive specialty areas of the efficient, effective, functional and integrated streamlined, alternating scale, inseparable, seamless and natural wrapping, interlacing, coiling, coupling, combining and interlocking techniques, designs, systems, routines, devices, manners, modes, fashions, forms, formats, factors, objects, initiatives, schemes, ocurrences, happenings, interactions, processes, methods, practices, movements, proceedings, messaging, presentations, notifications, flings, submissions, records, activities, actions, events, endeavors, tasks and affairs The so-called U.S. SEC is now approximately seventy years in operation, and its legal basis and justifiable reasoning for its purpose of existence is premised on legislative precedent of the so-called U.S. Securities Act of 1933s of congress, inclusive of every and all techniques, designs, systems, routines, devices, manners, modes, fashions, forms, formats, factors, objects, parts, segments, elements, components, constituents, ingredients, processes, methods and combinations pertaining to its vested legal charter and independent governing power and regulatory authority over every and all techniques, designs, systems, routines, devices, manners, modes, fashions, forms, formats, factors, objects, parts, segments, elements, components, constituents, ingredients, processes, methods and combinations concerning its responsibilities, duties and obligations to the aforementioned fragmenting capital market inefficiencies, so-called U.S. depositors and/or the citizens in members of the aforementioned UNVERSAL POPULACE™ of the so-called U.S. should never be questioned, objected to and/or circumvented by every and all other so-called U.S. federal independent agencies, so-called U.S. federal congressional senate and house representatives, so-called U.S. Presidents, so-called U.S. federal bench supreme, circuit or district trial court judges, other so-called U.S. state oriented independent agencies, so-called U.S. state congressional senate and house representatives, so-called U.S. state governors, so-called U.S. state bench supreme, circuit or district trial court judges, every and all industry and/or sector oriented initiatives, schemes, ocurrences, happenings, interactions, processes, methods, practices, movements, proceedings, messaging, presentations, notifications, filings, submissions, records, activities, actions, events, endeavors, tasks and affairs of lobbying interests groups, political appointees, public elected officials, public civil bureaucratic servants, members of the aforementioned UNIVERSAL POPULACE™, senior executives, board directors, audit committee members, independence committee members, compensation committee members, mid-level executive managers, personnel employee; internal auditors, public accountants, independent auditors, legal counsel, and/or every and all forms of institutional money FINANCIALS™ instruments clearing firms, so-called U.S. aforementioned PUBLIC FINANCIALS™ instruments settlement firms, so-called U.S. state oriented UNIVERSAL CAPITAL MARKET™ banking administrative authorities, so-called U.S. state oriented UNIVERSAL CAPITAL MARKET™ insurance administrative authorities, so-called U.S. state oriented aforementioned PUBLIC FINANCIALS™ instruments administrative authorities, so-called U.S. depositors, members of the aforementioned UNIVERSAL POPULACE™, members of the aforementioned UNIVERSAL POPULACE™ at large or every and all hereto members of the aforementioned UNIVERSAL POPULACE™ encompassing and/or involved in the banking, insurance and securities industries and sectors inclusive of, without limitation, every and all members of the aforementioned UNIVPESAL POPULACE™ pertaining to the distinctively separate and traditionally exclusive specialty areas of the efficient, effective, functional and integrated streamlined, alternating scale, inseparable, seamless and natural wrapping, interlacing, coiling, coupling, combining and interlocking techniques, designs, systems, routines, devices, manners, modes, fashions, forms, formats, factors, objects, parts, segments, elements, components, constituents, ingredients, processes, methods and combinations of public accounting, transport reconciling, independent auditing and financial reporting inclusive of, without limitation, efficient, effective, functional and integrated streamlined, alternating scale, inseparable, seamless and natural wrapping, interlacing, coiling, coupling, combining and interlocking techniques, designs, systems, routines, devices, manners, modes, fashions, forms, formats, factors, objects, parts, segments, elements, components, constituents, ingredients, processes, methods and combinations of order-entry quotation, matching, clearance, execution, settlement and exchange of insurance, risk financing, credit, cash management, transactional exchange banking, and aforementioned PUBLIC FINANCIALS™ instruments transactional exchange initiatives, schemes, ocurrences, happenings, interactions, processes, methods, practices, movements, proceedings, messaging, presentations, notifications, filings, submissions, records, activities, actions, events, endeavors, tasks and affairs whether or not every and all are involved in every and all aforementioned UCMOST™ real-time processing and/or reprocessing of data and/or information content management, financial foreign territories and whether or not every and all in aim, letter, spirit, nature, scope, breadth and/or depth reside and/or operate anywhere in the world pertaining to executive, political, legislative, judicial, regulatory, social, economic, operational, financial and/or transactional exchange initiatives, schemes, ocurrences, happenings, interactions, processes, methods, practices, movements, proceedings, messaging, presentations, notifications, filings, submissions, records, activities, actions, events, endeavors, tasks and affairs. The adaptive evolutionary positive enabling combinatorial impact of technological innovations in personal computer proprietary software programs and proprietary operating systems, hardware computing manufacture, artificial satellite, wireless and wire jack line communications infrastructure and network routing capacities in the three decades hereto are full capable of enabling the so-called U.S. SEC to reaffirm its vested legal charter and independent governing power and regulatory authority over the aforementioned fragmenting capital market inefficiencies to ensure complete adherence and fully enforceable compliance with every and all obscurant, irresponsible, feculent, irrational, feckless, disrespectful, mendacious, ignorant, malicious, condescending, untruthful, insolent, inefficient, incognizant, ineffective, fragmenting, unlettered, unpolished, presumptuous, portentous, pretentious, fruitless, disparate, antiquated, archaic, ancient history and superannuated so-called U.R. securities laws, governing rules and authoritative regulations from members of the aforementioned UNIVERSAL POPULACE™, so-called U.S. depositors, members of the aforementioned UNIVERSAL POPULACE™ and citizens which encompass members of the aforementioned UNIVERSAL POPULACE™ of the so-called U.S. The aforementioned fragmenting capital market inefficiencies has yet to be emancipate and enfranchised from the harming, damaging, inuring, insistent, insinuating, imposing, pestilent, impetuous, importune, pestiferous, condescending and insolent enthralling, hindering, entrapping, pretending, miring, fatiguing, maleficience, harassing, engulfing, pressing, malevolent, presuming, imprinting, malicious, suffocating, miring, strangling, repressing, entangling, pestering and oppressing which are traditionally concretizing via inefficient, ineffective, dysfunctional and fragmented vast networks of antiquated, archaic, ancient history and superannuated aforementioned PUBLIC FINANCIALS™ organizations which heretofore communicating conduit; of conceptual aide within a single holistically econometric marketplace environment. Whereas, it is an undeniable and evidentiary findings of fact, documented reference, logical scientific reasoning and intuitive analytical reasoning that every and all of the aforementioned further involve, concern and pertain to every and all techniques, designs, systems, routines, devices, manners, modes, fashions, forms, formats, factors, objects, parts, segments, elements, components, constituents, ingredients, processes, methods and combinations of factual holistically steady state continuous spectrum ubiquitous indistinguishably synchronous needs involving aforementioned UCMOST™ real-time processing and/or reprocessing of data and/or information content management, financial services and aforementioned PUBLIC FINANCIALS™ instruments transactional exchange initiatives, schemes, ocurrences, happenings, interactions, processes, methods, practices, movements, proceedings, messaging, presentations, notifications, filings, submissions, records, activities, actions, events, endeavors, tasks and affairs which are heretofore unmet by every and all so-called skilled practicioners whom heretofore evince works of art which are comprehensively imprudent, generally insolent and broadly unacceptable. The existence of a free-market enterprise whose purpose is to ensure that the so-called U.S. SEC continually has available every and all techniques, designs, systems, routines, devices, manners, modes, fashions, forms, formats, factors, objects, parts, segments, elements, components, constituents, ingredients, processes, methods and combinations of novel venues and/or mediums involving multivariate innovative techniques, designs, systems, devices, processes, parts, segments, methods, combinations, know-how, ideas, art forms, articles of manufacture, discoveries, formulae, and architectural engineering of streamlined procedural computing process design compositions to offer members of the aforementioned UNIVERSAL POPULACE™ innovative groundbreaking and breakthrough utility engineering and architectural design propagations universal microprocessor computing design provisions to ensure they are offered a never before seen capacity to self-manage and deposit their ownaforementioned PUBLIC FINANCIALS™ instruments to protect, sustain and expand their treasure accounting, financial fueling and econometric energizing in a highly dynamic and integrally risk programs, software computer program icons, proprietary operating systems, operating system icons and every and all other necessarily technological advancements necessary to uphold the complex and diversified multivariate so-called U.S. securities laws, governing rules and authoritative regulations inclusive of their letter, spirit, nature should be a requisite in novel, unknown, unforeseen and unprecedented aforementioned efficient UNIVERSAL CAPITAL MARKET™. The positive enabling impact of free-mayed and free-market integration of self-developed innovative technologies promulgated by strategic business enterprises in combination with the so-called U.S. SEC's vested legal charter and independent governing power and regulatory authority imminently paves the road toward establishing a new theater of operations premised on an innovative panacean cutting-edge technological oriented digital bridge platform which promulgates higher standards of fu disclosure, best practices, best executions, enhanced fairness, simultaneous equality, full transparency, consolidated access and perpetual integration of members members of the aforementioned UNIVERSAL POPULACE™ via efficient, effective, functional and integrated streamlined, alternating scale, inseparable, seamless and natural wrapping, interlacing, coiling, coupling, combining and interlocking techniques, designs, systems, routines, devices, manners, modes, fashions, forms, formats, factors, objects, parts, segments, elements, components, constituents, ingredients, processes, methods and combinations entailing, encompassing, comprising, involving, impacting and/or effecting all of the aforementioned fragmenting capital market inefficiencies which so-called U.S. President Franklin D. Roosevelt set forth the legal basis and justifiable reasoning for eradicating nearly seventy years ago via the so-called U.S. Securities Act of 1933 and the so-called U.S. Securities Exchange Act of 1934. Whereas, it is an undeniable and evidentiary findings of fact, documented reference, logical scientific deduction and intuitive analytical reasoning that the premised on documented references and evidentiary regulatory initiatives that the so-called U.S. SEC is maying and capable of reassessing its full reign of every and all techniques, designs, systems, routines, devices, manners, modes, fashions, forms, formats, factors, objects, parts, segments, elements, components, constituents, ingredients, processes, methods and combinations pertaining to its vested legal charter and independent UNIVERSAL POPULACE™ from around the world which necessarily require enhanced fairness, simulteanoues equality, full transparency, consolidated access and perpetual integration to pertinent every and all techniques, designs, systems, routines, devices, manners, modes, fashions, forms, formats, factors, objects, parts, segments, elements, components, constituents, ingredients, processes, methods and combinations aforementioned PUBLIC FINANCIALS™ statements seamlessly and naturally wrapped, twisted, mixed, convoluted, embroidered and combined in connection with aforementioned PUBLIC FINANCIALS™ instruments from members of the aforementioned UNIVERSAL POPULACE™. Historically, it appeared that the so-called U.S. SEC's capacity to fully enforce so-called U.S. securities laws, governing rules and authoritative regulations was consequentially less than would otherwise be expected due to the prevailing political, social, financial, and economic forces that preempted the so-called U.S. SEC stipulations, governing rules and authoritative regulations pertaining to complete adherence and fully enforceable compliance pertaining to the U.S. Securities Act of 1933 inclusive of, without limitation, the U.S. Securities and Exchange Act of 1934. It is a clear and undeniable findings of fact, documented reference, logical scientific deduction and intuitive analytical reasoning that istorically, large-scale lobbying efforts from interests groups in the Washington, District of Columbia, within, throughout and transcending the so-called beltway of the so-called U.S. national capital have traditionally competed via propagating, harnessing and leveraging every and all of the aforementioned fragmenting capital market inefficiencies, and thus thereby enthralled the so-called U.S. SEC, members of the aforementioned UNIVERSAL POPULACE™ to their unsubstantiated rigid positions and illogical rationalized reasoning for not requiting complete adherence and fully enforceable compliance to so-called U.S. securities laws, governing rules and authoritative regulations from every and all members of the aforementioned UNIVERSAL POPULACE™ participating within the aforementioned fragmenting capital market inefficiencies as was stipulated nearly seventy years ago as a congressional legal precedent. Every and all such interest group lobbying initiatives, schemes, ocurrences, happenings, interactions, processes, methods, practices, movements, proceedings, messaging, presentations, notifications, filings, submissions, ancient history and superannuated whence precluding, preventing, oppressing, represssing and obstructive to every and all self-initiated private enterprise concerted efforts at propagating free-market promulgated technological innovations initiatives from strategic business enterprises fully capable of facilitating the so-called U.S. SEC's ability to utilize the full extent of its vested legal charter and independent governing power and regulatory authority over the aforementioned fragmenting capital market inefficiencies by ensuring that proprietary software programs and proprietary operating systems applicable to every and all personal-computers, network computing structures and/or intelligent agent devices are hereafter equipped with such technological innovations necessary to ensure complete steadfast adherence and fully enforceable compliance to the rubricated pragmatic sanction hereto concretizing to eradicate, without exception, every and all obscurant, irresponsible, feculent, irrational, feckless, disrespectful, mendacious, ignorant, malicious, condescending, untruthful, insolent, inefficient, incognizant, ineffective, fragmenting, unlettered, unpolished, presumptuous, portentous, pretentious, fruitless, disparate, antiquated and archaic aforementioned fragmenting capital market inefficiencies. The so-called U.S. SEC has in recent history displayed its logical stance and justifiable reasoning for repossessing its vested legal charter and independent governing power and regulatory authority over the aforementioned fragmenting capital market inefficiencies by promulgating the rights and interests of the members of the aforementioned UNIVERSAL POPULACE™ in accordance with the foresight displayed by so-called U.S. President Franklin D. Roosevelt, by fully adopting and enacting recent adoption of a prohibition within the aforementioned fragmenting capital market inefficiencies of selectively disclosing every and all real-time processing and/or reprocessing of data and/or information receiver. The long awaited SEC ban on selective disclosure within the aforementioned fragmenting capital market inefficiencies and in derivative techniques, designs, systems, routines, devices, manners, modes, fashions, forms, formats, factors, objects, parts, segments, elements, components, constituents, ingredients, processes, methods and combinations in the W.W. capital markets is labeled and referred to as Regulation Fair Disclosure (Reg. FD). A Columbia University professor of so-called U.S. securities laws recently commented on the so-called U.S. each and every public organization which necessarily participates within the aforementioned fragmenting capital market inefficiencies. This Columbia University professor stated that although the so-called U.S. SEC's rules and regulations, in accordance with every and all obscurant, irresponsible, feculent, irrational, feckless, disrespectful, mendacious, ignorant, malicious, condescending, untruthful, insolent, inefficient, incognizant, ineffective, fragmenting, unlettered, unpolished, presumptuous, portentous, pretentious, fruitless, disparate, antiquated, archaic, ancient history and superannuated so-called U.S. securities laws, have always prohibited selective disclosure, the so-called U.S. SEC never spelled out what selective disclosure actually was or how it would enforce such so-called U.S. securities laws, governing rules and authoritative regulations beyond direct correlation to insider trading. The so-called U.S. SEC's recently adopted, enacted and now effective enforcement of Reg. FD as of Oct. 23, 2000 ensures that utilization of selected disclosure aforementioned PUBLIC FINANCIALS™ statements inclusive of seamlessly and naturally wrapped, twisted, mixed, convoluted, embroidered and combined in connection with aforementioned PUBLIC FINANCIALS™ instruments distributed to senior executives, members of the aforementioned UNIVERSAL POPULACE™, pension managers, mutual funds, transactional exchange advisors, transactional exchange management consultants, transactional exchange bankers, commercial bankers, insurance underwriters, financial analysts inclusive of, without limitation, high-net worth members of the aforementioned UNIVERSAL POPULACE™ by the senior executives members of the aforementioned UNIVERSAL POPULACE™ is, as has historically been stipulated in legal precedent which dates nearly seventy-years hereto, unequivocally illegal. With Reg. HD, the so-called U.S. SEC began the process of paving the regulatory future to achieve synchronicity with the already free-mayed and free-market innovative and technologically panacean cutting-edge innovative developments and technological advancements to completely resolve the tremendously long-held and enormously heartfelt need in the relevant arts applicable to holistically steady state continuous spectrum ubiquitous indistinguishably synchronous needs involving aforementioned UCMOST™ real-time processing and/or reprocessing of data and/or information content management, processes, methods, practices, movements, proceedings, messaging, presentations, notifications, filings, submissions, records, activities, actions, events, endeavors, tasks and affairs. The so-called U.S. SEC votes were cast three members to one in favor of adopting and enacting this regulatory mandate barring every and all members of the aforementioned UNIVERSAL POPULACE™ and their employed senior executives from furnishing, divulging or disclosing every and all techniques, designs, systems, routines, devices, manners, modes, fashions, forms, formats, factors, objects, parts, segments, elements, components, constituents, ingredients, processes, methods and combinations of every and all real-time processing and/or reprocessing of data and/or information receiver to selected senior executives, members of the aforementioned UNIVERSAL POPULACE™, pension managers, mutual funds, transactional exchange bankers, commercial bankers, financial analysts, inclusive, without limitation, high net-worth members of the aforementioned UNIVERSAL POPULACE™. It's fair to acknowledge that Reg. FD shall have an enormous impact on the world of public organizational enterprise-wide management operations and which thereupon concretizes profound implications for the manners, methods, processes and venues via whichmembers of the aforementioned UNIVERSAL POPULACE™ report public information to members of the aforementioned UNIVERSAL POPULACE™. The present SEC Chairman, Mr. Arthur Levitt, a long-time outspoken critic of the utilization of selective disclosure, was recently quoted as saying that selective disclosure unfairly gives a privileged few access to information which is subsequently utilized to make illegal aforementioned PUBLIC FINANCIALS™ instruments transactional exchanges before the information is reported and subsequently disseminated to members of the aforementioned UNIVERSAL POPULACE™ . It was also reported that the so-called U.S. SEC Chairman believes Reg. FD brings every and all obscurant, irresponsible, feculent, irrational, feckless, disrespectful, mendacious, ignorant, malicious, condescending, untruthful, insolent, inefficient, incognizant, ineffective, fragmenting, unlettered, unpolished, presumptuous, portentous, pretentious, fruitless, disparate, antiquated, archaic, ancient history and superannuated so-called U.S. depositors, so-called U.S. citizen taxpayers, and members of the aforementioned UNIVERSAL POPULACE™, regardless of the size of their subject to SEC regulatory sanctions and civil injunctions inclusive of, without limitation, mandatory regulatory imposed fines and charges. The positive enabling impact of full disclosure, best practices, best executions, enhanced fairness, simulteanoues equality, full transparency, consolidated access and perpetual integration to aforementioned PUBLIC FINANCIALS™ statements in connection with aforementioned PUBLIC FINANCIALS™ instruments on the performance measurement standards, earnings capacity, stakeholder profitability, and long-term economic stability members of the aforementioned UNIVERSAL POPULACE™ from around the world is at the core of liquidity, transparency and efficiency in an increasingly expanding aforementioned efficient UNIVERSAL CAPITAL MARKETED Additionally, the accurate, reliable, verifiable, transparency and efficient flow of every and all real-time processing and/or reprocessing of data and/or information receiver pertaining to holistically steady state continuous spectrum ubiquitous indistinguishably synchronous needs involving aforementioned UCMOST™ real-time processing and/or reprocessing of data and/or information content management, financial services and aforementioned PUBLIC FINANCIALS™ instruments transactional exchange initiatives, schemes, ocurrences, happenings, interactions, processes, methods, practices, movements, proceedings, messaging, presentations, notifications, filings, submissions, records, activities, actions, events, endeavors, tasks and affairs among members of the aforementioned UNIVERSAL POPULACE™ is the critical ingredient necessary to establish the cash liquidity, financially solvency, and economic stability necessary to formulate, promulgate and expand the aforementioned efficient UNIVERSAL CAPITAL MARKET™. Whereas, it is an undeniable and evidentiary findings of fact, documented reference, logical scientific deduction and intuitive analytical reasoning that the heretofore so-called U.S. capital market is vastly ridden with deep-seated traditional interests and long-standing industry positions which represent the vast networks of antiquated, archaic, ancient history and superannuated aforementioned PUBLIC FINANCIALS™ organizations which enthrall members of the aforementioned UNIVERSAL POPULACE™, thus amplifying oppression of free-may and free-market innovative panacean cutting-edge technological developments and advancement in the distinctively separate and traditionally exclusive deteriorates trust and confidence in so-called U.S. capital market and restricts the establishment of a single liquid, transparency and efficient so-called U.S. capital market inclusive of, without limitation, seamless integration in the W.W. capital markets premised on enhanced fairness, simulteanoues equality, full transparency, consolidated access and perpetual integration. As it pertains to the aforementioned fragmenting capital market inefficiencies an article dated Sep. 24, 1999 in the Miami Herald business section reported that the so-called U.S. SEC Chairman, Mr. Arthur Levitt, urged industry and sector-wise professionals to consider forming a central market for the orders members of the aforementioned UNIVERSAL POPULACE™ at specified decimal based prices, wherein the Chairman we on to state that the more orders that interact with one another, the better the prices shall be. In another more recent Miami Herald business article dated Nov. 5, 1999, the so-called U.S. SEC Chairman Levitt raised concern about the changes occurring in the present new york city based so-called Wall Street, because as he noted some firms are not finding the best execution for the orders members of the aforementioned UNIVERSAL POPULACE™ because of the way they handle the clearance, executions, settlement and exchange of orders to buy and/or sell aforementioned PUBLIC FINANCIALS™ instruments. The so-called U.S. SEC Chairman, Mr. Arthur Levitt went on to report that he is afraid firms sacrifice getting the best execution for the transactional exchange oriented customers orders by deciding to match a limited amount of buy and sell orders internally, and predominately routing orders to firms that pay for trades outside of the physical and electronic exchanges themselves. The so-called U.S. SEC Chairman believes transactional exchange brokers/dealers, pension managers, mutual funds, registered representatives, and all other accounting and financial professionals, directly or indirectly, are responsible for providing best execution pertaining the transactional exchange initiatives, schemes, ocurrences, happenings, interactions, processes, methods, practices, movements, proceedings, messaging, presentations, notifications, filings, submissions, records, activities, actions, events, endeavors, tasks and affairs members of the aforementioned UNIVERSAL POPULACE™. It is acknowledged that he strongly believes that solving these various dilemmviataining to aforementioned fragmenting capital market complete adherence and fully enforceable compliance with the standards of assuring members of the aforementioned UNIVERSAL POPULACE™ of best practices and best executions inaforementioned PUBLIC FINANCIALS™ instruments transactional exchange initiatives, schemes, ocurrences, happenings, interactions, processes, methods, practices, movements, proceedings, messaging, presentations, notifications, filings, submissions, records, activities, actions, events, endeavors, tasks and affairs. The so-called U.S. SEC Chairman has emphatically stressed the importance of finding ways to link all markets together into a single aforementioned efficient UNIVERSAL CAPITAL MARKET™ so that members of the aforementioned UNIVERSAL POPULACE™ are assured of getting the best execution for their aforementioned PUBLIC FINANCIALS™ instruments transactional exchange initiatives, schemes, ocurrences, happenings, interactions, processes, methods, practices, movements, proceedings, messaging, presentations, notifications, filings, submissions, records, activities, actions, events, endeavors, tasks and affairs. The so-called U.S. SEC Chairman has publicly reaffirmed that findings the way is not a job for the so-called U.S. SEC and its not a job for the so-called U.S. government, the free-markets of a single holistically econometric marketplace environment just do not work and/or function that way. The so-called U.S. SEC Chairman is emphatic in claiming that special transactional exchange orders to purchase or sell securities at specified prices are not readily executed because, after being placed on one physical and/or electronic exchange, they cannot be matched with similar transactional exchange orders on competing markets. The so-called U.S. SEC Chairman has also expresses interest in a proposal to combine the self-regulatory units aforementioned fragmenting capital market inefficiencies into a single self-regulatory organization separate from the exchanges. As far back as 1998, the so-called U.S. SEC Chairman, Mr. Arthur Levitt, who interestingly held that position of power and authority longer than any other presiding Chairman of the so-called U.S. SEC, has been extremely outspoken about the need to create a single aforementioned efficient UNIVERSAL CAPITAL MARKET™. It is undeniable that UCMOST information technology imminently propagates a novel and unobvious melioristic logical positivism rubric pragmatic isomorphic transmute heliocentric paradigm shift toward concretizing techniques, designs, systems, routines, devices, manners, modes, fashions, forms, formats, factors, objects, parts, segments, elements, components, constituents, ingredients, processes, methods and combinations entailing, encompassing, comprising, involving, impacting and/or effecting automatizing real-time holistically steady state synchronized ubiquitous continuum real-time rhombus microprocessing instantaneous transmission and receiver transforming traverse conduit aforementioned UCMOST™ real-time processing and/or reprocessing of every and all public accounting, transport reconciling, independent auditing and financial reporting embroidered, combined and interlocked with a melioristic logical positivism rubric pragmatic isomorphic transmuting heliocentric paradigm shift toward concretizing efficient, effective, functional and integrated streamlined, alternating scale, inseparable, seamless and natural wrapping, interlacing, coiling, coupling, combining and interlocking techniques, designs, systems, routines, devices, manners, modes, fashions, forms, formats, factors, objects, parts, segments, elements, components, constituents, ingredients, processes, methods and combinations entailing, encompassing, comprising, involving, impacting and/or effecting automatizing real-time holistically steady state synchronized ubiquitous continuum real-time rhombus microprocessing instantaneous transmission and receiver transforming traverse conduit aforementioned UCMOST™ real-time processing and/or reprocessing of every and all order-entry quotation, matching, clearance, execution, settlement and exchange of insurance, risk financing, credit, cash management, investment banking and aforementioned PUBLIC FINANCIALS™ instruments transactional exchange initiatives, schemes, ocurrences, happenings, interactions, processes, methods, practices, movements, proceedings, messaging, presentations, notifications, filings, submissions, records, activities, actions, events, endeavors, tasks and affairs to castigate every and all of the aforementioned fragmenting capital market inefficiencies whereby realizing new and higher standards of efficiency and effective to ensuring complete steadfast adherence and fully enforceable compliance to rubricated UCMOST real-time processing and/or reprocessing via harnessing and leveraging every and all of the aforementioned efficient UNIVERSAL CAPITAL MARKET conceptual aids hereafter propagated, proclaimed and promulgated via rubric isogloss melioristic logical positivism transmuting of every disrespectful, mendacious, ignorant, malicious, condescending, untruthful, insolent, inefficient, incognizant, ineffective, fragmenting, unlettered, unpolished, presumptuous, portentous, pretentious, fruitless, disparate, antiquated, archaic, ancient history and superannuated disrespect and lack of adherence and compliance to so-called U.S. securities law, governing rules and authoritative regulations of a capital market. Although most lobbying interest groups from the banking, securities and insurance industry professions always sought to promulgate initiatives to overcome Glass-Steagall barriers to entry in each others business enterprise initiatives, which historically prevented consolidated offerings of full-service banking, securities and insurance products and services to members of the aforementioned UNIVERSAL POPULACE™ it is difficult to logically understand or even justifiably comprehend why these same business industry interest group lobbying initiatives would even attempt to work against ensuring complete adherence and fully enforceable compliance to so-called U.S. securities laws, governing rules and authoritative regulations heretofore under the vested legal charter and independent governing power and regulatory authority of the so-called U.S. SEC, if not exclusively due to mendacious, raptorial, carnivorous and malicious undertakings which are unearthly and ungodly in their ruthlessness and voracious jealous and greed driven ultimatum lust for earning so-called profit while consciously suppressing, enthralling, oppressing, engulfing and disrespecting the hundreds of millions of individual members of the aforementioned UNIVERSAL POPULACE. It is important to recognize and acknowledge that the so-called U.S. SEC always had the legal precedent, vested legal charter and independent governing power and regulatory authority to dictate every and all of the forms, parts, means, segments, manners, methods, processes, technologies and venues potentially deemed necessarily utilizable by every and all members of the aforementioned UNIVERSAL POPULACE™ to ensure full disclosure, best practices, best executions, enhanced fairness, simultaneous equality, full transparency, consolidated access and perpetual integration of every and all individual members of the aforementioned UNIVERSAL POPULACE™. It now more evident than ever before in so-called U.S. history that since the passage of the so-called U.S. Securities Act of 1933 and so-called U.S. Securities Exchange Act of 1934, and the establishment proprietary operating systems, hardware computing, communications infrastructure and network routing capacities, to enable the so-called U.S. SEC to requisite from members of the aforementioned UNIVERSAL POPULACE™ whichever every and all are furthermore undeniably, logically, scientifically and intuitively deduced, apprehended and invoked as necessarily integrated, critically important and increasingly integral members of the aforementioned UNIVERSAL POPULACE™ complete adherence and fully enforceable compliance to so-called U.S. securities laws, governing rules and authoritative regulations had never materialized to the stages of development concretizing in the previous three decades hereto. Every and every and all members of the aforementioned UNIVERSAL POPULACE™ involved within an aforementioned efficient UNIVERSAL CAPITAL MARKET™ must ensure complete adherence and fully enforceable compliance to FCPA Part II to maintain every and all techniques, designs, systems, routines, devices, manners, modes, fashions, forms, formats, factors, objects, parts, segments, elements, components, constituents, ingredients, processes, methods and combinations which facilitate governing requisites and ensure the strict requirements of FCPA Part II by maintaining internal controls regarding high-technology automatizing systems of internal budgeting, corporate governance and random internal auditing of every and all accurate, timely, reliable and verifiable economic resources, financial transactions, operational occurrences, recurring events, miscellaneous items, and cost or expense driven initiatives, schemes, ocurrences, happenings, interactions, processes, methods, practices, movements, proceedings, messaging, presentations, notifications, filings, submissions, records, activities, actions, events, endeavors, tasks and affairs. It it unacceptably ironic and exclusively unearthly and ungodly that so-called U.S. equity and debt oriented derivative instrument options exchanges are heretofore pitted against the so-called U.S. equity and debt non-derivative instrument aforementioned PUBLIC FINANCIALS™ instruments exchanges such as the NYSE and the NASDAQ motivated by jealousies and greed for so-called market share which neither party has the technological capcity or melioristic logical positivism innovative desire to concretize for the benefit of the hundreds of millions of members of the aforementioned UNIVERSAL POPULACE, wherefrom thereupon subjecting the so-called market place individual equities via the 1982 SEC and Commodities Future Trading Commission (CFTC) accord prohibition agreements. The regulation of the aforementioned fragmenting capital market inefficiencies since the 1982 SEC and CFTC accord has been governed by under a system of split regulatory structure between the so-called U.S. SEC and the CFTC which concerned every and all transactional exchange initiatives, schemes, ocurrences, happenings, interactions, processes, methods, practices, movements, proceedings, messaging, presentations, notifications, filings, submissions, records, activities, actions, events, endeavors tasks and affairs over aforementioned PUBLIC FINANCIALS™ instruments involving respectively aforementioned PUBLIC FINANCIALS™ instruments and derivative PUBLIC FINANCIALS™ instruments. The CFTC's recent decision to phase out its governing regulatory oversight over limited techniques, designs, systems, routines, devices, manners, modes, fashions, forms, formats, factors, objects, parts, segments, elements, components, constituents, ingredients, processes, methods and combinations of derivative aforementioned PUBLIC FINANCIALS™ instruments, which have particularly involved futures and commodities, verifies that the historical dual oversight and split jurisdictions regulatory structured system within the aforementioned fragmenting capital market inefficiencies has always been and/or promulgated a vast network of inefficient, ineffective, dysfunctional and fragmented so-called U.S. capital market. It is a finding of fact that such a historical dual oversight and split jurisdictions regulatory structured system in the so-called U.S. is contrary to most single independent oversight and jurisdictional regulatory structured systems in place in other major sovereign industrialized and developed nations from around the world. It is evidentiary documented reference that the so-called U.S. SEC considered the 1982 SEC and CFTC 1982 accord its most far-reaching and tempestuous exponentially detrimental policy mistake pertaining to its capacity to enact and/or promulgate policy making decisions in accordance with every and all obscurant, irresponsible, feculent, irrational, feckless, disrespectful, mendacious, ignorant, malicious, condescending, untruthful, insolent, inefficient, incognizant, ineffective, fragmenting, unlettered, unpolished, presumptuous, portentous, pretentious, fruitless, disparate, antiquated, archaic, ancient history and superannuated so-called U.S. securities inefficiencies because it perpetuated the aforementioned fragmenting capital market inefficiencies inclusive of, without limitation, every and all derivative products and services applicable to every and all aforementioned PUBLIC FINANCIALS™ instruments related to the same so-called U.S. capital market. The so-called U.S. SEC and CFTC 1982 promulgated the aforementioned fragmenting capital market inefficiencies into a extreme anomaly in contrast to other sovereign national aforementioned PUBLIC FINANCIALS™ instruments environments around the world which tempestuous diminished its perceived independent governing power and regulatory authority over the aforementioned fragmenting capital market inefficiencies and in derivative fashion promulgated same across the W.W. capital markets. Thus, the recent decision by the CFTC to completely resolve these matters and issues by terminating its existence in a phase out period makes the 1982 accord between and among the so-called U.S. SEC and CFTC a mute point, and which thereupon consolidates every and all independent governing power and regulatory authority over the aforementioned fragmenting capital market inefficiencies in the vested legal charter of the so-called U.S. SEC enacted according to seventy-year old legal precedent via the so-called U.S. Securities Exchange Act of 1934. Moreover, in a speech titled a Question of Integrity: Promoting Depositor Confidence by Fighting Insider Trading presented on Feb. 27, 1998, the so-called U.S. SEC Chairman raised two specific observations: (1) members of the aforementioned UNIVERSAL POPULACE™ should not utilize selective disclosure aforementioned PUBLIC FINANCIALS™ statements to certain influential members of the aforementioned UNIVERSAL POPULACE™, senior executives, financial analysts, institutional money managers, and retail oriented aforementioned PUBLIC FINANCIALS™ instruments account executives in order to curry favor with them and reap a tangible benefit, such as a positive press spin; and (2) in-house lawyers members of the aforementioned UNIVERSAL POPULACE™ are to counsel their employers that during the window of time in which only some members of the aforementioned UNIVERSAL POPULACE™, senior executives, financial analysts, institutional money managers, and retail oriented aforementioned fragmenting capital market inefficiencies commission income earning account executives have been told selective information—those members of the aforementioned UNIVERSAL POPULACE™ impacted by said information. Furthermore, the so-called U.S. SEC and its staff having recently extensively studied the issue of selective disclosure among other items in comprehensive techniques, designs, systems, routines, devices, manners, modes, fashions, forms, formats, factors, objects, parts, segments, elements, components, constituents, ingredients, processes, methods and combinations, formulated, authored and published a statement from Chairman Arthur Levitt on Dec. 15, 1999 pertaining to audit committee oversight, selective disclosure, and insider trading offering guidelines and standards concerning those matters, issues and topics wherein Chairman Levitt unknowingly, inapropriately, inefficiently, imprudently, portentiously, irrationally and illogically exhorted that members of the aforementioned UNIVERSAL POPULACE™ transport so-called fragmented management conference calls to the so-called wire jack line and/or so-called wireless inefficient, portentous and fruitless so-called to ineffectively propagate proliferation of inefficient broadcasting, transporting, communicating, distributing and syndicating data and/or information whereby promulgating further entrenchment of the aforementioned fragmenting capital market inefficiencies. Whereas, hereinabove notwithstanding as of 1998, the so-called U.S. SEC Chairman has been urging members of the aforementioned UNIVERSAL POPULACE™ to improve their reporting, dissemination and booking, classifying, categorizing, adjusting, altering, revising, changing, charging billing, collecting, producing, composing, conducting, proofing, filtering, pressing, publishing, cataloging, indexing, posting, compressing, releasing, playing, displaying, broadcasting, distributing and/or syndicating of PUBLIC FINANCIALS™ statements while further emphasizing to members of the aforementioned UNIVERSAL POPULACE™ that they must unequivocally avoid manipulating earnings profitability to meet the estimated projections and/or expectations members of the aforementioned UNIVERSAL POPULACE™, senior executives, financial analysts, institutional money managers, and retail oriented aforementioned PUBLIC FINANCIALS™ instruments account executives involved in propagating aforementioned fragmenting capital market inefficiencies. Whereas, it is an undeniable and evidentiary findings of fact, documented reference, logical scientific without limitation, invigorated honor and integrity including the utilization of full disclosure, best practices and best executions should be adamantly and rigorously invoked, harnessed and leveraged to rid a single holistic econometric capital market of every and all, without limitation, of the aforementioned fragmenting capital market inefficiencies, for the benefit of the cash liquidity, financial solvency and economic stability of the hundreds of millions of members of the aforementioned UNIVERSAL POPULACE™. Whereas, it is an undeniable and evidentiary findings of fact, documented reference, logical scientific reasoning and intuitive analytical reasoning that although every and all of the so-called U.S. SEC chairman's efforts and initiatives, schemes, ocurrences, happenings, interactions, processes, methods, practices, movements, proceedings, messaging, presentations, notifications, filings, submissions, records, activities, actions, events, endeavors, tasks and affairs should be commended in the highest degree possible, the so-called U.S. SEC chairman as aforementioned is not responsible nor is it's role to solve the inherent problems and technological inefficiencies which engulfand enthrall aforementioned fragmenting capital market inefficiencies, rather that is the role of ordinary people who understand the tremendously long-held and enormously heart-felt needs in the relevant art and thus sacrifice their time, money and energy to promulgate positive enabling changes among member; of the aforementioned UNIVERSAL POPULACE™ to assist them respectively in conceptualizing the tempestuous exponentially debilitating implications not invoking aforementioned UCMOST™ information technology to ensure formation of new theater of operations premised exclusively on a melioristic logical positivism rubricated isomorphic transmuting paradigm shift to higher standards of enhanced fairness, simultaneous equality, full transparency, and consolidated access inclusive, without limitation, invigorated honor and integrity including the utilization of best practices and best executions to supplant every and all of the aforementioned fragmenting capital market inefficiencies on behalf of the members of the aforementioned UNIVERSAL POPULACE™ via innovative and technologically panacean cutting-edge innovative developments and technological advancements which form a digitizing technological bridge platform premised on aforementioned UCMOST™ real-time processing and/or specialty areas involving public accounting, transport reconciling, independent auditing and financial reporting inclusive of, without limitation, securing the eradicating polarization of the heretofore distinctively separate and traditionally exclusive specialty areas involving order-entry quotation, matching, clearance, execution, settlement and exchange of insurance, risk financing, credit, cash management, investment banking and aforementioned PUBLIC FINANCIALS™ instruments via the prudent, responsible and logical integration of every and all available technological innovations in personal computer proprietary software programs and proprietary operating systems, inclusive of, without limitation, every and all hardware computing manufacture, communications infrastructure, and network routing capacities leveraging every and all historical innovative developments and technological advancements implemented over the previous three decades to uphold every and all multivariate so-called U.S. securities laws, governing rules and authoritative regulations inclusive of their aim, letter, spirit, nature, scope, breadth and depth to concretize every and all coupling and combinatorial techniques, designs, systems, routines, devices, manners, modes, fashions, forms, formats, factors, objects, parts, segments, elements, components, constituents, ingredients, processes, methods and combinations to offer members of the aforementioned UNIVERSAL POPULACE™ innovative groundbreaking and breakthrough utility engineering and architectural design propagations evincing universal microprocessor computing design provisions conceived, engineered and design as innovatively hermetic lock up caster casing interlocking microprocessor computing operating systems, software programs, business methods, and new combinations, pertaining to programmed instruction entailing, encompassing, comprising, involving, impacting and/or effecting every and all one-time programmable read-only memory (PROM) of every and all computing central processing unit (CPU) within a universe ebroidering, comprising and embodying personification of a capital market.

5. Public Capital Market Economics

The positive enabling impact of the machine, processes, capacities, methodology and antiquated, archaic, ancient history and superannuated so-called wire jack line and/or so-called wireless conduits evincing proliferation of the inefficient, portentous and fruitless so-called Internet inclusive of, without limitation, the inefficient, portentous and fruitless so-called World Wide Web, shall hereby for ages and ages be documented, evinced and perpetually recognized as the least practical, least unifying, least useful, least necessary and least functional so-called advancement and development in the history of mankind. Whereas, hereby invoking the richly powerful technological forces embodied and embroidered within the aforementioned UCMOST™ information technology is a unequivocal, undeniable, evidentiary, logical, technical, scientific and intuitively comprehensively useful, generally pertinent and broadly useful absolute resolution thereto. Whereas, it is an undeniable and evidentiary findings of fact, documented reference, logical scientific deduction and intuitive analytical reasoning that the aforementioned UCMOST™ information technology is intrinsically capable of being comprehensively suitable, generally pertient and broadly useful as default go to communications tool for every and all global civilizations to interact, efficiently, effectively, functionally and seamlessly throughout the world, as if there were no national borders to sovereign nations, while still retaining, implementing and supervising strict sensitivity to programming with adherence to local regulations, cultural backgrounds, ideologies, norms, morals and/or languages. Whereas, it is an undeniable and evidentiary findings of fact, documented reference, logical scientific deduction and intuitive analytical reasoning that the so-called U.S. government has recently begun to adapt its methods of surveying the country to arrive at an efficient, effective, objective, well-informed, risk-managed and self-assured transactional exchange generated barometer regarding our economic output and growth rates relative to our work force employment status simply due to the imminent changes being deployed in the marketplace throughout the world. This is extraordinary, and it changes the standards, procedures and concepts that govern the way business-to-business products/services and transactions inclusive of, without limitation, business-to-consumer products/services and transactions are devised, manufactured, deployed, transacted, and retrieved, converted, formatted, processed, stored, gathered, compiled, tabulated, prepared, presented, submitted, validated, verified, locations throughout the world with no limits on boundaries. Within an article published in the business section of the Miami Herald dated Oct. 29, 1999, the Bureau of Economic Analysis (BEA); the so-called U.S. agency in charge of tracking the so-called U.S. economy reported that new survey methods and changes in the way software is publicly accounted making the change for them being acknowledged as transactional exchanges and not expenses thereby make a dramatic impact on economic meters. Upon recognizing this undeniable and evidentiary findings of fact, documented reference, logical scientific deduction and intuitive analytical reasoning, the so-called U.S. government revised its growth estimate for 1992 to 1998, from a +3.2% annual rate of growth to +3.6%, after adjusting for the so-called notion of inflation. Upon further review, it becomes evident that the so-called U.S. economy is US$250 billion larger than previously reported, and thus making is readily apparent that the so-called U.S. economy relies more on technology, information and consumer spending than every and all techniques, designs, systems, routines, devices, manners, modes, fashions, forms, formats, factors, objects, parts, segments, elements, components, constituents, ingredients, processes, methods and combinations of factory output. Thereupon and hereafter, the so-called U.S. government and other sovereign nations need to deposit and adjust to adaptive evolutionary techniques, designs, systems, routines, devices, manners, modes, fashions, forms, formats, factors, objects, parts, segments, elements, components, constituents, ingredients, processes, methods and combinations of seamless automatizing real-time transmission propagating transporting transmuting partible beta particle beam gliding transponder converting receiver conduit real-time processing of data and/or information receiver, transport, conversion, formatting, processing, storing, gathering, compiling, tabulating, casting, calculating, preparing, presenting, verifying, submitting, confirming, validating, booking, classifying, categorizing, adjusting, altering, revising, changing, charging, billing, collecting, producing, composing, conducting, proofing, filtering, pressing, publishing, cataloging, indexing, posting, compressing, releasing, playing, displaying, broadcasting, distributing and/or syndicating transmission, rebroadcasting, redistributing and/or resyndicating transmission economic every and all real-time processing and/or reprocessing of data and/or information receiver to members reprocessing of data and/or information receiver to seamlessly and naturally effectuating efficient, effective, streamlined, objective, well-informed, risk-managed and self-assured aforementioned PUBLIC FINANCIALS™ instruments transactional exchange decision initiatives, schemes, ocurrences, happenings, interactions, processes, methods, practices, movements, proceedings, messaging, presentations, notifications, filings, submissions, records, activities, actions, events, endeavors, tasks and affairs involving every and all aforementioned PUBLIC FINANCIALS™ instruments to protect, sustain and expand their treasure accounting, financial fueling and econometric energizing in a highly dynamic and intrinsically global marketplace. In another article published in the business section of the Miami Herald and dated Jan. 12, 2001, it was reported that then so-called U.S. President William Clinton's annual Economic Report authored by his Council of Economic Advisors forecasted their perspective analysis of the future levels of economic growth rates and development in the following decade. The so-called White House Economic Report of the so-called U.S. President promulgated by the Council of Economic Advisors focused on how technological advances have stimulated and transformed the so-called U.S. economy in the previous decade, and attempted to forecast their belief that in the coming ten years the so-called U.S. economy may display solid economic growth while they inherently perceive increases in unemployment rates. The White House Economic Report of then so-called U.S. President William Clinton expected to be delivered to the so-called U.S. Congress shortly after being authored predicted that the soaring economy of recent years may be replaced by slower but steady growth. Apparently, this White House Economic Report of then so-called U.S. President William Clinton referenced that as of year ended 1999 the so-called U.S. economy, as measured by the Gross Domestic Product, grew at a rate of +5% and as of the year ending 2000 at a rate of +3.7%. As noted, the Gross Domestic Product is a hypothetical average statistical inference that attempts to measure the total value of merchandising products, goods, supplies and services in the so-called U.S. economy produced by members of the aforementioned UNIVERSAL POPULACE™ in the so-called U.S., wherein the Gross National Product is a hypothetical average statistical inference that attempts to measure the final total of merchandising products, goods, supplies and services in the so-called of growth rate of the so-called U.S. economy as measured by the Gross Domestic Product as anticipated by the Council of Economic Advisors of the historical administration of then so-called U.S. President William Clinton. Then so-called U.S. President William Clinton's Council of Economic Advisors believe the so-called U.S. economy may increase at approximately +3% annually over the coming seven years, and further perceive that thereafter it may begin slowing to approximately +2.9% level of growth around 2008, with potential increases in the unemployment rates of the so-called U.S. economy from 4% as of the year ending 2000 to approximately +5.1% during the same projected period of potential economic development. In distributing the report to members of the aforementioned UNIVERSAL POPULACE™ prior to delivering it to the so-called U.S. Congress, the chairman of then so-called U.S. President's Council of Economic Advisors who apparently authored the report believes the fundamentals of the so-called U.S. economy are strong and does not believe the so-called U.S. economy displays the potential of entering a recession in the coming months. The chairman of then so-called U.S. President's Council of Economic Advisors acknowledged that the so-called U.S. economy has slowed in recent months more than the Council of Economic Advisors and others' had expected and/or anticipated, but therein attempted to forecast a return to a solid postive trend of so-called U.S. economic growth and development by the so-called U.S. SECond half of the year ending 2000. It is further reported in the White House Economic Report of then so-called U.S. President's Council of Economic Advisors that they believe the underlying support of the recent economic growth and development trend of the so-called U.S. economy was apparently due to increases in productivity increases achieve in the last five years. The obscure terminology of productivity increases is meant to represent that with the same number of workers employed members of the aforementioned UNIVERSAL POPULACE™ are capable of producing much more merchandising products, goods, supplies and services in the so-called U.S. economy in comparison to previous periods of economic growth rates and developments. Whereas, it is an undeniable and evidentiary findings of fact, documented reference, logical scientific deduction and intuitive analytical reasoning that innovative and technologically panacean cutting-edge development and advancements applicable to processes methods, practices movements, proceedings, messaging, presentations, notifications, filings, submissions, records, activities, actions, events, endeavors, tasks and affairs via utility engineering and architectural design propagations universal microprocessor computing design provisions can serve and assist as positive utility engineering and architectural design propagations universal microprocessor computing design provisions enabling independent market force to enable members of the aforementioned UNIVERSAL POPULACE™ to monitor the aforementioned PUBLIC FINANCIALS™ statements inclusive of seamlessly and naturally wrapped, twisted, mixed, convoluted, embroidered and combined in connection with aforementioned PUBLIC FINANCIALS™ instruments from members of the aforementioned UNIVERSAL POPULACE™ with aforementioned PUBLIC FINANCIALS™ instruments transactional data and public aforementioned PUBLIC FINANCIALS™ instruments finanical transactional exchange instrument transactional non-financial information with aforementioned fragmenting capital market inefficiencies inclusive of, without limitaiton their ability to gather data and infomrimation onf patters and trends, analyze the present liquidity, financial solvency and economic stability of public organizatoins while assessing their overall budgets, expenditures, performance and profitability are comprehensively suitable, generally pertinent and broadly useful to these PUBLIC FINANCIALS™ statements in every and all divisional and consolidated techniques, designs, systems, routines, devices, manners, modes, fashions, forms, formats, factors, objects, parts, segments, elements, components, constituents, ingredients, processes, methods and combinations and within an transnational standardized format to facilitate their ability to seamlessly and naturally effectuating efficient, effective, streamlined, objective, well-informed, risk-managed and self-assured aforementioned PUBLIC FINANCIALS™ instruments transactional exchange decision initiatives, schemes, ocurrences, happenings, interactions, processes, methods, practices, movements, proceedings, messaging, presentations, notifications, filings, submissions, records, activities, actions, events, endeavors, tasks and affairs involving every and all aforementioned PUBLIC FINANCIALS™ instruments to protect, sustain and expand their treasure accounting, financial fueling and econometric energizing in the present documented reference, logical scientific deduction and intuitive analytical reasoning that over the course of the previous three decades hereto varying demonstrated and present evince their utter incapacities of actualizing the technological skills necessary to create the capability to harness the unlimited power of concretizing techniques, designs, systems, routines, devices, manners, modes, fashions, forms, formats, factors, objects, parts, segments, elements, components, constituents, ingredients, processes, methods and combinations of compositions that are intrinsically and integrally twisted, bundled and combinatorial panacean cutting-edge graphical user interfaces, proprietary software programs, software program icons, proprietary operating systems programs, and proprietary operating systems program icons, tailored around innovative techniques, designs, systems, devices, processes, parts, segments, methods, combinations, know-how, ideas, art forms, articles of manufacture, discoveries, formulae, and architectural engineering of streamlined procedural computing process design compositions, inclusive of, without limitation, hardware computing manufacture, artificial satellite wireless and wired communications infrastructure, and network routing capacities to thereof and thereby offer members of the aforementioned UNIVERSAL POPULACE™ innovative groundbreaking and breakthrough utility engineering and architectural design propagations to concretize establishment of a novel, unobvious, unique, unknown, unforeseen and unprecedented aforementioned efficient UNIVERSAL CAPITAL MARKET™ which realizes an innovative panacean cutting-edge technological bridge oriented digital platform applicable to every and all techniques, designs, systems, routines, devices, manners, modes, fashions, forms, formats, factors, objects, parts, segments, elements, components, constituents, ingredients, processes, methods and combinations of the basic elemental developments, necessary interactions and integral transactional exchange initiatives, schemes, ocurrences, happenings, interactions, processes, methods, practices, movements, proceedings, messaging, presentations, notifications, filings, submissions, records, activities, actions, events, endeavors, tasks and affairs found prevalent with aforementioned fragmenting capital market inefficiencies to facilitate a timely, reliable, verifiable, efficient, functional, consolidated and seamlessly integrated UNIVERSAL ECONOMY™ which may thereupon offer processing and/or reprocessing of data and/or information receiver in every and all basic functional elements and transactional exchange initiatives, schemes, ocurrences, happenings, interactions, processes, methods, practices, movements, proceedings, messaging, presentations, notifications, filings, submissions, records, activities, actions, events, endeavors, tasks and affairs found prevelant within an aforementioned efficient UNIVERSAL CAPITAL MARKET™. Whereas, it is an undeniable and evidentiary findings of fact, documented reference, logical scientific deduction and intuitive analytical reasoning that the enormous amoung of so-called U.S. dollar equivalent values inaforementioned PUBLIC FINANCIALS™ instruments which are continuoously at stake in the present inefficient, dsyfunctional, fragemented and disintegrated aforementioned fragmenting capital market inefficiencies are exacerbated by the increasing volumes of public aforementioned PUBLIC FINANCIALS™ instruments financial transactional exchange isntruments transactional exchange initiatives, schemes, ocurrences, happenings, interactions, processes, methods, practices, movements, proceedings, messaging, presentations, notifications, filings, submissions, records, activities, actions, events, endeavors, tasks and affairs present effectuated by members of the aforementioned UNIERSAL POPULACE™ within an aforementioned efficient UNIVERSAL CAPITAL MARKET™ which can ill-afford to enable enable the technological and structural foundation therein to wither and become obsolete over the course of time especially given that the present global marketplace is highly dynamic and integrally volatile, and further driven by the trust and confidence in the capacity of consumers to purcahse and the ability of innovators to continue innovative developments and technological advancements in information technology. Additionally, it is clearly an undeniable and evidentiary findings of fact, documented reference, logical scientific deduction and intuitive analytical reasoning that the exuberant fees, charges, surcharges, and sales commissions imposed on members of the aforementioned UNIVERSAL POPULACE™ for borrowing and/or saving currency related economic sums inclusive of, without limitation, the related transactional exchange fees, clearning fees, service charges, surcharges, and sales commissions required to seamlessly and naturally transactions in the ancient history and present inefficient, ineffective, dysfunctional and aforementioned UNIVERSAL POPULACE™ from around the world while they pursue to ability to protect, sustain and expand their treasure accounting, financial fueling and econometric energizing in a highly dynamic and inherently volatile, fragile, frigid and ruthless global marketplace. It is also an undeniable and evidentiary findings of fact, documented reference, logical scientific deduction and intuitive analytical reasoning that the cost of capital by itself can debilitate the cash liquidity, financial solvency, economic stability, and normal growth rate of entire industries and sectors which comprise the industrialized, developed and developing sovereign economies from around the world who have the wherewithal to meet the debt oriented claims and obligations against the assets and residual equitities available therein, but the preconceived notion that members of the aforementioned UNIVERSAL POPULACE™ from around the world can assume the arbitrarily imposed and negatively tempestuous exponentially debilitating impacts of the heretofore inefficient, dysfunctional, fragemented and disintegrated so-called U.S. cpaital market inclusive of the heretofore inefficient, dysfunctional, fragmented and disintegrated W.W. capital markets, given their limited access to wealth and unreasonable borrowing capacities is simply incorrect, illogical and further emphatically runs contrary in aim, letter, nature, breadth, sound, depth, spirit and scope to what free-market sovereign economies of a single holistically econometric marketplace environment should afford to individual members of the aforementioned UNIVERSAL POPULACE™ in the way of remedial assistance and utility engineering and architectural design propagations of universal microprocessor computing system provisions which strive for prudent, sound and sustainable economic development, growth and expansion without promulgating tempestuous exponentially debilitating increases in the systematic volatility and detrimental increases in the costs of capital of a single holistically econometric marketplace environment, thereby enabling established norms, ways, mores and sustainable capacities to survive well into tommorow's future.

6. Public Capital Market Banking

Whereas, tens of thousands members of the aforementioned UNIVERSAL understand their inevitable, logical and justifiable dependence on the experience, innovation, creativity, experimentation, imagination, knowledge, skills, talents and abilities of senior executives who serve as either owners and/or directors, and further may be employed by members of the aforementioned UNIVERSAL POPULACE™ which inevitably participate with aforementioned fragmenting capital market inefficiencies. These senior executives collectively represent their commercial business interests and affairs and those of governmental, associational, not-for-profit, group, medical and judicial organizations, hereafter collectively referred to as public organization, and thereby serve the immedaite gratification of clients, customers, citizens and constituents from around the world, but fail completely to service the higher calling unmet needs in the relevant art of every and all of the individual members of the aforementioned UNIVERSAL POPULACE™. Whereas, it is an undeniable and evidentiary findings of fact, documented reference, logical scientific deduction and intuitive analytical reasoning that members of the aforementioned UNIVERSAL POPULACE™ depend on these senior executives and the members of the aforementioned UNIVERSAL POPULACE™ who own and/or serve as directors, and further may be employed by in some capacity or another to concretize the treasure accounting, financial fueling and econometric energizing of the global economy inclusive of, without limitation, the existence aforementioned fragmenting capital market inefficiencies in every and all techniques, designs, systems, routines, devices, manners, modes, fashions, forms, formats, factors, objects, parts, segments, elements, components, constituents, ingredients, processes, methods and combinations. It is also an undeniable and evidentiary findings of fact, documented reference, logical scientific deduction and intuitive analytical reasoning that expectations, anticipations, hopes, wishes, desires, concerns, uncertainties and fears members of the aforementioned UNIVERSAL POPULACE™ pertaining to the reporting of accurate, timely, reliable and verifiable every and all real-time processing and/or reprocessing of data and/or information receiver which include, without limitation, every and all techniques, designs, systems, routines, devices, manners, modes, fashions, forms, formats, factors, objects, parts, segments, elements, components, constituents, ingredients, processes, methods and combinations aforementioned PUBLIC FINANCIALS™ instruments from members of the aforementioned UNIVERSAL POPULACE™ inclusive of, without limitation, aforementioned PUBLIC FINANCIALS™ instruments transactional exchange data with aforementioned PUBLIC FINANCIALS™ instruments transactional exchange information represent the intrinsic basis for delineating every and all expectations, anticipations, hopes, wishes, desires, concerns, uncertainties and fears pertaining to the concretizing historical and present, and therein prospective economic resources, financial transactions, operational occurrences, recurring events, miscellaneous items, and cost or expense driven initiatives, schemes, ocurrences, happenings, interactions, processes, methods, practices, movements, proceedings, messaging, presentations, notifications, filings, submissions, records, activities, actions, events, endeavors, tasks and affairs, and more specifically, forecasting the present values of future cash flows, expenditures, disbursements, and requisitions, inclusive of every and all potential earnings, taxes, and profits which thereform derive members of the aforementioned UNIVERSAL POPULACE™ preferential interests in their chosen selection of one aforementioned PUBLIC FINANCIALS™ instruments over another with aforementioned fragmenting capital market inefficiencies. It is further an undeniable and evidentiary findings of fact and logical scientific deduction reasoning that members of the aforementioned UNIVERSAL POPULACE™ with every and all rudimentary understanding of forward-looking intrinsic value may hereto be offered innovative utility engineering and architectural design provisions to acquire the necessary resources, education, knowledge, experience, skills, tools and abilities, inclusive of all enhanced fairness, simulteanoues equality, full transparency, consolidated access and perpetual integration to aforementioned fragmenting capital market inefficiencies inclusive of, without limitation, every and all of its historical, real-time and prospectively available accurate, timely, reliable and verifiable every and all real-time processing and/or reprocessing of data and/or information receiver, to thereupon prudently and from a calculated and risk-managed position entrust themselves and their own intellectual capacities inclusive of their self-disciplines to therewith assume full capacity self-management of their ownaforementioned PUBLIC FINANCIALS™ instruments portfolio to therein protect, sustain and expand their treasure accounting, financial fueling business section, it was reported that the Consumer Federation of America, a Washington-based alliance of 270 not-for-profit consumer groups recently analyzed and extracted certain date that was ascertained from reports previously undertaken by the ancient history so-called U.S. Federal Reserve Board of Governors, ancient history so-called U.S. Federal Open Market Committee and the ancient history so-called U.S. Federal Reserve Bank. The Consumer Federation of America logically deduced that +53% of so-called U.S. families get by in their day-to-day lives on a paycheck-to-paycheck basis, and approximately +50% have less than US$10,000 in cash or assets inclusive of retirement assets which are readily convertible to heretofore so-called U.S. currency monies. Furthermore, the Consumer Federation of America analysis of the ancient history so-called U.S. Federal Reserve Board of Governors, ancient history so-called U.S. Federal Open Market Committee and the ancient history so-called U.S. Federal Reserve Bank data identified that in the early 1980's, so-called U.S. families retained or saved an average of +8% of the currency and/or assets that remained at their disposal after paying their debts, and as of 1998 the savings percentage figure fell to half of one percent, and by the year ending 2000 the savings percentage figure was in negative territory, respectively, independently, autonomously, evidently, undeniably, logically, scientifically and intuitively indicating that so-called U.S. families, during the year ending 2000, did not save for retirement in a diligently planned effort to protect, sustain and expand their treasure accounting, financial fueling and econometric energizing in the highly volatile and dynamic global marketplace. This obviously enlightening and increasingly important analysis by the Consumer Federation of America alliance further accents the importance of assisting members of the aforementioned UNIVERSAL POPULACE™ in any an all techniques, designs, systems, routines, devices, manners, modes, fashions, forms, formats, factors, objects, parts, segments, elements, components, constituents, ingredients, processes, methods and combinations with utility engineering and architectural design provisions which can offer them necessary knowledge, experience, skills, resources, tools and abilities, inclusive of enhanced fairness, simulteanoues equality, full transparency, consolidated access and perpetual elimination of every and all, without limitation, of the aforementioned fragmenting capital market and/or information receiver to assist them to protect, sustain and expand their treasure accounting, financial fueling and econometric energizing well into the future. In regards to a prudent review of every and all techniques, designs, systems, routines, devices, manners, modes, fashions, forms, formats, factors, objects, parts, segments, elements, components, constituents, ingredients, processes, methods and combinations pertaining to aspects involving the structural foundation and banking system available to individual members of the aforementioned UNIVERSAL POPULACE™ to specifically self-manage their own treasure accounting, financial fueling and econometric energizing within, throughout and transcending a single holistically econometric marketplace environment, we should herein conceptualize and understand the present aggregate structural foundation and banking system in place inclusive of the International Monetary Banking System heretofore available to the world which heretofore is settled among nations by the so-called International Bank of Settlement in Brussels, while therein beginning our focus and exclusive attention on the structural foundation and banking system of the undeniable world leading sovereign nation of the global economy the so-called United States of America. The heretofore so-called premise of the so-called U.S. dominace within a single holistically econometric marketplace environment rests exclusively on the inappropriate preconceived notions of offering members of the aforementinoed UNIVERSAL POPULACE™ credit in advance of their ability to generate enough income to sustain immediate repayment of interest charges and principal debt incurred for accessing available electronic forms of currency monies which clearly, undeniably, logically, scientifically and intuitively runs contrary to every and all principles of accounting and finance which drive the letter, intent, breadth, depth, scope and spirit of a capital market which instrinsically entails, encompasses, comprises, involves, impacts and effects every and all, without limitation, of the national sovereign industrialized, developed and developing free-market commerce and trade bloc economies within, throughout and transcending global econometric marketplace environment. The preconceived notions that individual members of the aforementioned UNIVERSAL POPULACE™ should portentously, pretentiously and obtrusively against every and all better judgement and in direct contradiction to the prudent man rule of adequately and immediately clear the real-time payment for products, goods, services and supplies is undeniably, scientifically, logically and intuitively incorrect, unnecessary, unwarranted and unjustifiable because it prolongs the impoverishment and enthrallment of the individual members of the aforementioned UNIVERSAL POPULACE™ given their limited access to wealth and unreasonable borrowing capacities is simply incorrect, illogical and further emphatically runs contrary in aim, letter, nature, breadth, sound, depth, spirit and scope to what free-market sovereign economies of a single holistically econometric marketplace environment should afford to individual members of the aforementioned UNIVERSAL POPULACE™ in the way of remedial assistance and utility engineering and architectural design propagations of universal microprocessor computing system provisions which strive for prudent, sound and sustainable economic development, growth and expansion without propagating tempestuous exponentially debilitating increases in the systematic volatility and detrimental increases in the costs of capital of a single holistically econometric marketplace environment, thereby enabling established norms, ways, mores and means to survive well into tommorow's future. Whereas, it is an undeniable and evidentiary findings of fact, documented reference, logical scientific deduction and intuitive analytical reasoning that within an article published in the business section of the Miami Herald, dated, Mar. 18, 2001, it is reported that a so-called Fair, Isaac & Co. (fi company) credit scors from an aforementioned PUBLIC FINANCIALS™ organization stations in San Rafael, California who supposedly heretofore developed and inefficiently and ineffecitvely supplies guise, untimely, time-lagged, dated, restraining, restricting, vexing, impovershing, predatory, pretentious, portentous, imprudent, unsuitable and hereto antiquated, arachic and ancient history so-called credit scoring reports approximately 70% of the so-called antiquated, archaic, ancient history and superannuated personal financial information credit profiling to every and all of the aforementioned PUBLIC FINANCIALS™ organizations which pre-determine whether or not to extend so-called lines of crediit entailing, encompassing, comprising, involving, impacting and/or effecting every and all evidentiary non-existent availability to currencies monies related to so-called credit cards, so-called check draft cards and/or so-called pre-paid debit cards and/or so-called equity-backed loans, inventory asset-backed loans, so-called mortgage equity-backed loans and so-called mortgage to acquire, transfer, leverage, purchase, sale and/or license necessarily requited basic overhead shelter from the natural elements applicable to a capital market within, throughout and transcending a single holistically econometric marketplace environment. Whereas, it is an undeniable and evidentiary findings of fact, documented reference, logical scientific deduction and intuitive analytical reasoning that within an article published in the business section of the Miami Herald, dated, Mar. 18, 2001, it is reported that this arbitrarily imposed and undisclosed methodology for rating and storing the so-called credit profiling file of so-called fi company scores on aforementioned PUBLIC FINANCIALS™ organizations inclusive of individual members of the aforementioned UNIVERSAL POPULACE™ are supposedly existent to pre-determine the payment history, the outstanding debt balances, the forms of establishing so-called credit line availability to evidentiary non-existent currency monies, the so-called health mix of the so-called credit line availability to evidentiary non-existent currency monies and the so-called amount of requests from merchandising aforementioned PUBLIC FINANCIALS™ organiztions to access these so-called credit line availability to evidentiary non-existent currency monies protentously, imprudently and predatorially offered to individual members of the aforementioned UNIVERSAL POPULACE™. Whereas, it is an undeniable and evidentiary findings of fact, documented reference, logical scientific deduction and intuitive analytical reasoning that within an article published in the business section of the Miami Herald, dated, Mar. 18, 2001, it is reported that under the guise of antiquated, archaic, ancient history and superannuated two decade old U.S. legislation these heretofore so-called fi company scores processed through the heretofore so-called credit reporting aforementioned PUBLIC FINANCIALS™ organizations, namely every and all of the following: so-called Equifax; so-called Trans Union; and so-called Experian heretofore claims to ability to restrict, hold, prevent and precluded the access of these heretofore so-called fi company scores from being released directly to members of the aforementiond UNIVERSAL POPULACE™ as a rebuttal to plenty of prudent prudent requests to the contrary from so-called legislative congressional representatives and so-called public line offering aforementioned PUBLIC FINANCIALS™ organizations of non-existent and non-backed currency monies to effectute efficient, effective, objective, well-informed, risk-managed and self-assured decisions related to aforementioned PUBLIC FINANCIALS™ instruments transactional exchange decision initiatives, schemes, ocurrences, happenings, interactions, processes, methods, practices, movements, proceedings, messaging, presentations, notifications, filings, submissions, records, activities, actions, events, endeavors, tasks and affairs hereto via antiquated, archaic and ancient hisotry so-called underwriting needs to preconceive the so-called worthiness and/or unworthiness of members of the aforementiond UNIVERSAL POPULACE™. Moreover, so-called scores of credit line availability to non-existent currency monies and/or account processing formation originations from aforementioned PUBLIC FINANCIALS™ organizations between and among every and all separate aforementioned PUBLIC FINANCIALS™ organizations and members of the aforementioned UNIVERSAL POPULACE™ are also compiled to affix, classify and categorize antiquated, archaic, ancient history and superannuated so-called credit profililing to effectuate every and all transactional exchange decision initiatives, schemes, ocurrences, happenings, interactions, processes, methods, practices, movements, proceedings, messaging, presentations, notifications, filings, submissions, records, activities, actions, events, endeavors, tasks and affairs from every and all of the following; so-called Standard & Poor's; so-called Moody's Investors Services, so-called Dun & Bradstreet; so-called Value Line; so-called Morningstar; wherefrom every and all hereto antiquated, archaic and ancient hisotry so-called underwriting need to preconceive the so-called worthiness and/or unworthiness of members of the aforementioned PUBLIC FINANCIALS™ organizations and/or hereto more specifically individual members of the aforementioned UNIVERSAL POPULACE™. Furthermore, it is an undeniable and evidentiary findings of fact, documented reference, logical scientific deduction and intuitive analytical reasoning that within an article published in the business section of the Miami Herald, dated, Mar. 18, 2001, it is reported that under the guise of antiquated, archaic, ancient history and superannuated two decade old U.S. legislation upwards of 70% of the so-called top tier, major, prominet, well-established, all individual members of the aforementioned UNIVERSAL POPULACE™ to so-called selectively identify those whom a which are inappropriately, unjustly, inefficiently and unnecessarily utilize the guise of so-called underwriting guidelines heretofore due to a complete lack of comprehensively suitable, generally pertinent and broadly useful innovative and technologically panacean cutting-edge innovative developments and technological advancements invoked within aforementioned UCMOST™ information technology which hereafter render every and all preconceived notions that so-called antiquated, archaic, ancient history and superannuated so-called underwriting of credit innclusive of every and all obscurant, irresponsible, feculent, irrational, feckless, disrespectful, mendacious, ignorant, malicious, condescending, untruthful, insolent, inefficient, incognizant, ineffective, fragmenting, unlettered, unpolished, presumptuous, portentous, pretentious, fruitless, disparate, antiquated, archaic, ancient history and superannuated so-called credit profiling via rubric hereafter forever supplanted, wherefrom every and all obscurant, irresponsible, feculent, irrational, feckless, disrespectful, mendacious, ignorant, malicious, condescending, untruthful, insolent, inefficient, incognizant, ineffective, fragmenting, unlettered, unpolished, presumptuous, portentous, pretentious, fruitless, disparate, antiquated, archaic, ancient history and superannuated so-called antiquated, archaic, ancient history and superannuated techniques, processes and methods of untimely, time-lagged, dated, holding, restricting and restraining data processing and information orgination have no place whatsoever within an aforementioned efficient UNIVERSAL CAPITAL MARKET™ premised exlcusively on invoking the comprehensively suitable, generally pertient and broadly useful UCMOST™ information technology, and furthermore every and all scapegoating, hindering, entrapping, miring, fatiguing, exposing, mischief, miser, teasing, misgiving, lynching, beheading, hanging, targeting, misguiding, defaming, mishandling, misfeasance, misbelieving, misbranding, miscalling, and/or miscasting whatsoever premised on the antiquated, archaic, ancient history and superannuated preconceived notions that so-called ascertaining worthiness and/or unworthiness via proprietary credit profiling methodologies inclusive of antiquated, archaic and ancient hisotry credit profiling file prior to offering every and all antiquated, archiac and ancient history so-so-called credit scoring from separate aforementioned PUBLIC FINANCIALS™ organizations every and all of which intrinsically prevent, preclude, restrict and restrain full disclosure whichsoever are hereto equivocally, evidently, undeniably, logically, scientifically and intuitively rendered obsolete within a capital market impacting and/or effecting every and all national sovereign free-market commerce and trade bloc economies within, throughout and trascending a single global econometric marketplace environmwent. Whereto is concretizing a novel, unobvious, unknown, unforeseen, unprecedented, epoch, paper-less, ease of use, fruitful, opportune, never faltering and never failing panacean cutting-edge breakthrough utility engineering and groundbreaking technological architectural design innovation driven by a single independent, apolitical, impartial, independent, meloristically motivated, and rubric for-profit capital intensive, sole proprietor exclusively and perpetually driven by serving every and all of the econometric transactional exchange initiatives, schemes, ocurrences, happenings, interactions, processes, methods, practices, movements, proceedings, messaging, presentations, notifications, filings, submissions, records, activities, actions, events, endeavors, tasks and affairs of the hundreds of millions of individual members of the aforementioned UNIVERSAL POPULACE™ withwithin a capital market inclusive of, without limitation, every and all forms of life, work, play, recreation, leaisure, entertainment, travel inclusive of, without limitatoin, every and all levels of econometric transanctional exchange entailing, encompassing, comprising, involving, impacting and/or effecting every and all, without limitation, commercial business, associatonal, not-for-profit, group, governmental, medical and judicial operations, administrations and management of national soveriegn industrialized, developed and developing free-market commerce and trade bloc economies within, throughout and transcending a single global econometric marketplace enviornment wherefrom impacting and/or effecting every and all concretizing of hereto novel, unknown, unprecedented, unforeseen, ease of use and panacean cutting-edge innovative developments and technological advancements via invoking aforementioned UCMOST™ information technology therefrom efficiently and effectively enable facilitating and forming the hardcore consolidated econometric marketplace environment whence every and all assize hereto formulae of a new theater of access and perpetual integration of every and all individual members of the aforementioned UNIVERSAL POPULACE™ inclusive of, without limitation, every and all products, goods, supplies and services transcending every and all heretofore obfuscating so-called disciplinary fields comprising traditionally separate and distinctively exclusive specialty areas involving multifaceted sectors and multidimensional industries which are hereto clearly and evidentlay evinced as undeniably, logically, scientifically and intutively single members of aforementioned PUBLIC FINANCIALS™ organizations and members of the aforementioned UNIVERSAL POPULACE™ within a single holistically econometric marketplace environment, wherefrom hereto collectively all of this legal document and potentially patentable disclosure is actualized via literary, melodious, unifying, artistic and technical systems innate conception, terminological conveyance, indivisible rubric, syntactic oralformulaic, unique artwork, systematic arrangement, differentiated crafting, artistic construct, melodious lyrics, denominative literateness and thereat proprietary multiport revolving chambered binary hunting metallic track encasing hermetic new software lock up cast casing constrained unified real-time microprocessor machine language computer block keyhole combinational code belonging exclusively to a prenatal, heretofore, and at present direst impoverishment of every and all basic numeric metric system currency monies inclusive of every and all basic residential and commercial property, products, goods, services and supplies wherefrom nothwithstanding, a upstart single sole and prenuptial premier personified individual propagating and promulgating a inalienable cognitional preconceived and long-term prepared happenstance existential self-analytical, self-asserting, self-assured, self-cognitive, self-commanding, self-concerning, self-confessed, self-confident, self-conscious, self-contained, self-controlled, self-describing, self-devoting, self-effacing, hereto self-employed, self-esteemed, self-enforcing, self-examining, self-explaining, self-executing, self-fulfilling, self-governing, selfhood, selfidentification, selfimmolation, selfinduced, self-instructing, self-interested, self-insuring, self-justifying, self-limited, self-loving, self-loading, self-opinionated, self-ordained, self-perception, self-poised, self-possessed, self-preservation, self-proclaimed, self-propelled, self-purifying, self-realizing, self-referential, self-reflective, self-studying, self-styled, self-sufficient, self-trusting, self-vision, free association, freethinking and free will melioristic logical positivism demiurgical despot legal owner evincing an ardent, adamant, conscious, astute and shrewd world-class competitive staple independent innovator which hereto independently undertook a long-term preplanned arduous endeavor to create a formulae prefiguration of a semiabstraction unequivocal absolute resolution ease of use technological solution hereto concretizing consummate and constructive reduction to practice whence successfully achieving and apprehending free hold on assize aforementioned UCMOST™ information technology rubricated keyhole combinational, methodological and process actualized proprietary software object code. Thus, every and all members of the aforementioned UNIVERSAL POPULACE hereto evinces a capacity of being offered the utility of invoking aforementioned UCMOST™ information technology which intrinsically set forth an calculated exponential derivative utility provisional formation of new theater of operations and establishment of higher standards to concretize every and all full disclosure, best practices, best executions, enhanced fairness, simultaneous equality, full transparency, consolidated access and perpetual integration, without discrimination, selection, prejudice and/or bias of every and all individual members of the aforementioned UNIVERSAL POPULACE™ to a novel, unprecendented, unknown, unforeseen aforementioned efficient UNIVERSAL CAPITAL MARKET™, thus oncretizing a never before seen capacity to effectute efficient, effective, objective, well-informed, risk-managed and self-assured real-time decisions anywhere, anytime and anyplace within, throughout and transcending a single global economic therefrom empowering members of the aforementined UNIVERSAL POPULACE™ to effectuate every and all aforementioned PUBLIC FINANCIALS™ instruments transactional exchange decision initiatives, schemes, ocurrences, happenings, interactions, processes, methods, practices, movements, proceedings, messaging, presentations, notifications, filings, submissions, records, activities, actions, events, endeavors, tasks and affairs further empowering members of the aforementined UNIVERSAL POPULACE™ to effectuate every and all acquire, transfer, leverage, purchase, sale and/or license products, goods, services and/or supplies wherefrom being efficiently, effectively and functionally treasure accounting, financial fueling and econometric energizing within an innately volatile and heretofore intrinsically fragile, frigid and ruthless capital market of the national sovereign industrialized, developed and developing free-market commerce and trade bloc economies within, throughout and transcending a single holistically econometric marketplace environment wherefrom hereto every and all aforementioned and below mentioned is rubric. Whereas, it is an undeniable and evidentiary findings of fact, documented reference, logical scientific deduction and intuitive analytical reasoning that every and all preconceived notions entailing, encompassing, comprising, involving, impacting and/or effecting a capital market should hereto forever categorically and across-the-borad traversal be deemed rebricated, retooled, reformulated and reprogrammed via invoking the aforementioned UCMOST™ information technology inclusive of, without limitation, across-the-board traversal of every and all aforementioned PUBLIC FINANCIALS™ organizations and aforementiond UNIVERSAL POPULACE™ which are evidently, undeniably, logically, scientifically and intutively member participants and inhabitannts operating and/or residing between and among the national sovereign industrialized, developed and developing free-market commerce and trade bloc economies within, throughout and transcending a single holistically econometric marketplace environment. Whereas, it is an undeniable and evidentiary findings of fact, documented reference, logical scientific deduction and intuitive analytical reasoning that within an article published in the business section of the Miami Herald, dated Apr. 6, 2001, it is referenced that approximately 6,000 member aforementioned PUBLIC FINANCIALS™ organizations heretofore offer so-called credit cards to individual members of the aforementioned UNIVERSAL POPULACE™ with the greatest majority of these aforementioned PUBLIC FINANCIALS™ organizations utilizing illegal unfair trade and deceptive practices and increasingly and incorporating premeditated hard-nosed, frigid and ruthless practices under the guise of unequivcally misconstrued preconceived notions so-called competition with the exclusive intention of entrapping individual members of the aforementioned UNIVERSAL POPULACE™ into assuming debt which they undeniably, logically, scientifically and intuitively they cannot reasonably and/or prudently afford to assume given the national averages of wage income reference, logical scientific deduction and intuitive analytical reasoning that heretofore the approximately 6,000 member aforementioned PUBLIC FINANCIALS™ organizations which offer so-called credit cards to individual members of the aforementioned UNIVERSAL POPULACE™ engage in obtrusive hood-winking tactics and engage in raptorial entrapment via unfair enticement of individual members of the aforementioned UNIVERSAL POPULACE™ into assuming so-called payment schedules which include every and all unnecessary and imopportune late fees while simultaneously and fraudulently concealing deceptive provisions of extraordinarily high and unfathomably illogical interest rates premised on selective, arbitrary and undisclosed credit score alterations, manipulations, assessments, changes and impositions as a precondition to enabling every and all hereto inappropriate, unsuitable and imprudent advance of so-called availabe currency monies to acquire, transfer, leverage, purchase, sale and/or license products, goods, services and supplies prior to being capable of settling and clearing the payment of the interests charges and principal debt on these inappropriate, insolent, protentous, pretentious, boisterous, bolstering, predatory, raptorial, carnivorous, imprudent, unsuitable and inopportune whereform hereto antiquated, archaic, ancient history and superannuated so-called advanced lines of currency monies. Whereas, it is an undeniable and evidentiary findings of fact, documented reference, logical scientific deduction and intuitive analytical reasoning that heretofore approximately 6,000 member aforementioned PUBLIC FINANCIALS™ organizations referenced within the business section of the Miami Herald, dated Apr. 6, 2001, by Washington, D.C.-based so-called U.S. Public Interest Research Group, apparently a so-called public advocate think tank within the so-called beltway bandit access way surrounding the national capital of the so-called United States of America. Within this article the director of one of the divisions of the so-called U.S. Public Interest Research Group is referenced as stipulating that the members of the aforementioned PUBLIC FINANCIALS™ organizations which offer credit card receipt of payment inclusive of every and all aforementioned PUBLIC FINANCIALS™ organizations which offer so-called credit cards, check cards and/or pre-paid debit cards do everythinig possible under the preconceived notions of so-called justified and legal practices which scientifically and intuitively incorrect, obtrusive, imprudent, portentous, predatory, pretentious, impovershing, unjust, untruthful, unfair, vexing, enthralling, obstructing and pestiferous, wherefrom the guise and veiled preconceived notions which so-called allow individual members of the aforementioned UNIVERSAL POPULACE™ to be kept in the dark against their will with respect via exuberant, harming, damaging, inuring, insistent, insinuating, imposing, pestilent, impetuous, importune, pestiferous, condescending and insolent enthralling, hindering, entrapping, pretending, miring, fatiguing, maleficience, harassing, engulfing, pressing, malevolent, presuming, imprinting, malicious, suffocating, miring, strangling, repressing, entangling, pestering and oppressing tactics which are heretofore concretizing via the so-called expereienced and traditional inefficient, ineffective, dysfunctional and fragmented vast networks of antiquated, archaic, ancient history and superannuated aforementioned PUBLIC FINANCIALS™ organizations which heretofore continuously, arrogantly, imprudently, irrationally and irresponsibly engage in propagating aforementioned fragmenting capital market inefficiencies via the malformation of every and all communicating conduits of conceptual aids within, throughout and transcending a single holistically econometric marketplace environment. The publishing article within the business section of the Miami Herald, dated Apr. 6, 2001, further references that the alarming trend of the inefficient, ineffective, dysfunctional and fragmented vast networks of antiquated, archaic, ancient history and superannuated aforementioned PUBLIC FINANCIALS™ organizations offering so-called available lines, albeit undeniably, logically, scientifically and intuitivey non-existent, of currency monies via so-called credit to individual members of the aforementioned UNIVERSAL POPULACE™ is inappropriate, malicious, imprudent, demoralizing, enthralling and oppressive while running contrary to every and all priciples of finance which serve as the exclusive basis for ensuring their treasure accounting, financial fueling and econometric energizing within a heretofore undeniabley and evidentiary, logically, scientifically and intuitively dynamic, fragile, frigid and intrinsically volatile capital market which hereto strives for prudent, sound and sustainable economic development, growth and expansion without promulgating tempestuous exponentially debilitating increases in the systematic volatility and evidentiary findings of fact, documented reference, logical scientific deduction and intutive analytical reasoning that the greatest majority of the 6,000 companies which heretofore offer these so-called credit card lines of unavailable currency monies have increased their interest rates, assessments, charges, fees and sur-charges inclusive of every and all pricing, costing, operating, franchising, leasing, purchasing, financing and/or commissioning to make available the so-called lines of credit which are evidently, undeniably, logically, scientifically and intuitively unavailable currency monies while spreading the so-called competitive range of late fees anywhere from 50% to 133% using conservative analytical numeric semantics evincing across-the-board traversal of misleading acceptance of lower monthly repayment schedules without fully disclosing the findings of fact that the amounts of repayment for the incurred debt assumed by individual members of the aforementioned UNIVERSAL POPULACE™ are rising exponentially due to so-called back office continously and/or or compounding rates of interest charged on the debt outstanding in the ledger balance accounts of the individual members of the aforementioned UNIVERSAL POPULACE™, while unfairly in turn via so-called front-office methods are insolent in offering simple interest annualized compounding rates of returns to these same members of the aforementiond UNIVERSAL POPULACE™ for depositing their hard-earned income currency monies with these inefficient, ineffective, dysfunctional and fragmented. Furthermore, a large majority of the referenced approximately 6,000 member aforementioned PUBLIC FINANCIALS™ organizations within the business section of the Miami Herald, dated Apr. 6, 2001, which offer these inappropriate, malicious, imprudent, demoralizing, enthralling and oppressive so-called credit card, draft cards, check cards and pre-paid debit card services in malicious, raptorial and predatory fashion via heretofore continuously, arrogantly, imprudently, irrationally and irresponsibly engaging in propagating aforementioned fragmenting capital market inefficiencies via the malformation of every and all communicating conduits of conceptual aids within a single holistically econometric marketplace environment also engage in entrapping individual members of the aforementioned UNIVERSAL POPULACE™ via bait and switch tactics thereto offering cards under of guise so-called lower annual percentage rates and fees while leveraging promulgating and proclaiming and promulgated via every and all feculent, feckless, insolent, condescending, obnoxious, conceiting, vexing, obtrusive, suffocating, obfuscating, inefficient, fragmenting, strangling, intrusive, unmeritted, ineffective, menacing, stalking, pretentious, melacious, suppressing, presumptuous, stifling, portentous, disparate, strapping, fruitless, unmerciful, choking, entangling, unnecessary, unwarranted and unjustifiable exclusively for-profit exuberant, obstructing, phantom and veiled so-called commission and unaccountable invoice fees, charges and expenses and/or exclusively for-profit exuberant, obstructing, phantom and veiled so-called retainer plus unaccountable hourly invoice fees, charges and expenses, whence exclusively subjective business minded, driven, exploitative and profiteering heretofore so-called advocates of a heretofore inefficient, ineffective, antiquated, archaic, ancient history and superannuated so-called system of subjective jurisprudence and/or system of so-called subjective law, namely heretofore, without limitation, the greatest majority of all of the following: lawless, veiling, biased, subjective and unresolving employed lawyers; lawless, veiling, biased, subjective and unresolving lawyering proprietors; lawless, veiling, biased, subjective and unresolving employed mediators; lawless, veiling, biased, subjective and unresolving mediation proprietors; lawless, veiling, biased, subjective and unresolving employed arbitrators; lawless, veiling, biased, subjective and unresolving arbitration proprietors; lawless, veiling, biased, subjective and unresolving employed magistrates; lawless, veiling, biased, subjective and unresolving magistrating proprietors; lawless, veiling, biased, subjective and unresolving employed, elected and/or appointed jurist; lawless, veiling, biased, subjective and unresolving employed, elected and/or appointed jurist proprietors; every and all, without limitation, inclusive members of legal aforementioned PUBLIC FINANCIALS™ organizations within, throughout and transcending the national sovereign borders of a single holistically econometric marketplace environment, furthermore the greatest majority of whom, without limitation, are extravagantly insolent, condescending, self-aggrandizing, conceiting, and therewith perpetualy engage in, without limitation, all of the following: obfuscating; obstructing; lawlessness; enthralling; harrassing; oppressing; intimidating; aggradandizing; second-guessing; pretending; exaggerating; miser, teasing; misgiving; lynching; beheading; hanging; misguiding; defaming; mishandling; misfeasance; misbelieving; misbranding; miscalling; and miscasting; every and all of the hundreds of millions of individual members of the aforementioned UNIVERSAL POPULACE™ who can afford to clear and settle and/or cannot afford to clear and settle their exuberant, extravagent, unwarranted, unncessary, unjustifiable and unaccountable commission and/or retainer, plus unaccountable hourly invoice fees, charges and expenses for recovering a legal right and/or seeking unequivocal absolute resolution to a grievance, heretofore offered exclusively under clear, evident, undeniable, evidentiary, referenced, logically, scientifically and intuitvely as subjective for-profit business exploitative and profiteering initiatives, schemes, ocurrences, happenings, interactions, processes, methods, practices, movements, proceedings, messaging, presentations, notifications, filings, submissions, records, activities, actions, events, endeavors, tasks and affairs, heretofore defying every and all ethical standards and moral principles upon which the law of a nation is premised, whereof obscuring all notions and veiling a fallacy of their steadfast adherence to a so-called professional oath to serve the public for better and/or for worse, whereupon miscasting third so-called system of jurisprudence wherefrom perpetually heretofore misleading the universal citizenry into a preconception of so-called lawful, objective and independent persons and establishments for accessing truth and justice, inclusive of, without limitation, honor, integrity and proprieties within, throughout and transcending civilized societial nations via facilitating prompt aiding, access and guidance to securing a legal right and/or seeking redress of a grievance, whefrom every and all are exclusively heretofore premised on exclusively harnessing and for-profit leveraging a heretofore inefficient, ineffective, fruitless, unjust, obfuscating, untruth, obstructive, antiquated, archaic, ancient history and superannuated system of law and so-called civil, contract and/or criminal jurisprudence, wherefrom enabling, taunting, tempting, prompting, advising, guiding, advocating and propagating these so-called aforementioned PUBLIC FINANCIALS™ organizations to unfairly reserve the right to claim and whensoever effectuate imposing upon individual members of the aforementioned UNIVERSAL POPULACE™ a card with astronomically unjustifiable higher interest rates and extraordinarly unnecessary higher fees, while effectuating higher continously and/or daily interest rate charges and fees on the outstanding debt balances which exponentially increase their so-called earnings on each and every one of the ledger account balances of debt inappropriately, imprudently and unconsciously assumed by individual members of the aforementioned UNIVERSAL POPULACE™ thereby rendering their so-called no annual fee tactics to entice, entrap, enthrall individual members of the aforementioned UNIVERSAL POPULACE™ misleading and the premised so-called no annual fees a mute point given the trivial numismatic comparison with exponentially increasing interest rate charges and fees on the so-called debt balances outstanding within their ledger balance accounts. Moreover, it is an undeniable and evidentiary findings of fact, documented reference, logical scientific deduction and intuitive analytical reasoning that so-called misleading, inopportune, oppressive and obtrusive grace periods are being shortened to ensure these inefficient, ineffective, dysfunctional and fragmented vast networks of antiquated, archaic, ancient history and superannuated aforementioned PUBLIC FINANCIALS™ organizations are capable of charging exuberant and unreasonable interest rates and fees to further impoverish and engage in predatory practices which prevent and preclude members of the aforementioned UNIVERSAL POPULACE from focusing their attention and directing their hard-earned currency monies toward sustaining, protecting and expanding their treasure accounting, financial fueling and econometric energizing. Additionally, it is an undeniable and evidentiary findings of fact, documented reference, logical scientific deduction and intuitive analytical reasoning that under the guise of so-called competition a greatest majority of these inefficient, ineffective, dysfunctional and fragmented vast networks of antiquated, archaic, ancient history and superannuated aforementioned PUBLIC FINANCIALS™ organizations engage in the malevolent and maldistribution of each and every one of the ledger account balances of debt inappropriately, imprudently and many times unknowingly and unconsciously assumed by individual members of the aforementioned UNIVERSAL POPULACE™ via guise sale of the so-called divisions engaged in these so-called card financial services thereupon triggering clauses and articles within the so-called back of the offer misleading, unreadable and abstruse legal languages enabling them the unfairly reserve members of the aforementioned UNIVERSAL POPULACE™ have outstanding typically altering the time schedules of charging interests rates on the debt balance ledgers from so-called daily to continously compounding rates of return so-called earned by the inefficient, ineffective, dysfunctional and fragmented vast networks of antiquated, archaic, ancient history and superannuated aforementioned PUBLIC FINANCIALS™ organizations engage in the malevolent and maldistribution of financial services via so-called credit cards, check cards and/or pre-paid debit cards which increase the ledger account debt balances exponentially in comparison to daily compounding which over the course twelve months adds nearly one-half of one percentage point to the debt, but over any length of time can literally increase the debt outstanding by 200% depending on multifaceted and multidimensional variables inclusive of the initial static principal amount outstanding assuming the debt principal balance never increased thereafter. According to the U.S. Public Interest Group a member of the so-called public advocate beltway bandit group of politically subsidized think tanks, it is an undeniable and evidentiary findings of fact, documented reference, logical scientific deduction and intuitive analytical reasoning that the inefficient, ineffective, dysfunctional and fragmented vast networks of antiquated, archaic, ancient history and superannuated aforementioned PUBLIC FINANCIALS™ organizations offering these so-called card financial services to individual members of the aforementioned UNIVERSAL POPULACE™ on an overall situation is worse than it has ever been since the dawn of these untimely, inopportune and misleading so-called immdiately available lines of currency monies which are undeniably, logically, scientifically and intuitively nonexistent as so-called hard-currency backed monetary borrowing to acquire, transfer, leverage, purchase, sale and/or license products, goods, services and supplies prior to being capable of settling and clearing the payment of the interests charges and principal debt on these inappropriate, insolent, protentous, pretentious, boisterous, bolstering, predatory, raptorial, carnivorous, imprudent, unsuitable and inopportune so-called advanced lines of currency monies. Thereupon, as a professional scientific technological innovator within the specialty fields of efficient, effective, functional and integrated streamlined, alternating scale, inseparable, seamless and natural wrapping, interlacing, elements, components, constituents, ingredients, processes, methods and combinations entailing, encompassing, comprising, involving, impacting and/or effecting automatizing real-time holistically steady state synchronized ubiquitous continuum real-time rhombus microprocessing instantaneous transmission and receiver transforming traverse conduit aforementioned UCMOST™ real-time processing and/or reprocesing involving every and all public accounting, transport reconciling, independent auditing and financial reporting inclusive of, without limitation, aforementioned UCMOST™ real-time processing and/or reprocessing invoving every and all order-entry quotation, matching, clearance, execution, settlement and exchange of insurance, risk financing, credit, cash maangement and aforementioned PUBLIC FINANCIALS™ instruments to ascertain for the benefit of members of the aforementioned UNIVERSAL POPULACE a novel and unobvious capacity to effectute efficient, effective, objective, well-informed, risk-managed and self-assured aforementioned PUBLIC FINANCIALS™ instruments transactional exchange decision initiatives, schemes, ocurrences, happenings, interactions, processes, methods, practices, movements, proceedings, messaging, presentations, notifications, filings, submissions, records, activities, actions, events, endeavors, tasks and affairs it is emphatically, undeniably, logically, unequivocally, scientifically and intuitively extremely necesssary to analyze, assess and scrutinize every and all heretofore existence of the structural foundation, functional operations, transactional exchange initiatives, and therein potential importance of, or lack thereof, of the heretofore so-called International Monetary Banking System, with specific focus on the antiquated, archaic, ancient history and superannuated so-called Internal Revenue Service, the antiquated, archaic, ancient history and superannuated so-called U.S. Federal Reserve Board of Governors, antiquated, archaic, ancient history and superannuated so-called U.S. Federal Open Market Committee and the antiquated, archaic, ancient history and superannuated so-called U.S. Federal Reserve Bank inclusive of, without limitation, its role and function in the so-called U.S. banking system, the so-called U.S. economy every and all of which continuously, maliciously and imprudently engage in propagating the aforementioned fragmenting capital market inefficiencies, it is an undeniable and evidentiary findings that a single holistically econometric marketplace environment lacks constituents, ingredients, processes, methods and combinations of applied unequivocal absolute resolution information technology to mitigate the heretofore inefficient, ineffective, dysfunctional and fragmented state of the billing, collection and banking system found prevalent therein. Heretofore, most nations throughout the world utilize the financial intermediary assistance of multilateral organizations such as the World Bank or the International Monetary Fund inclusive of settlement of debts via the International Bank of Settlements in Brussels, to borrow non-existent so-called backed hard currency dollars which are then exchange into non-existent so-called backed soft currency monies which are domestically inapporpriately authoritatively accepted and wide-spread in circulation within every and all national sovereign bordered countries to facilitate austerity and economic growth and development plans and strategies with so-called assistance from other major industrialized nations, particulary through the so-called industrialized great five (G-5), the so-called industrialized great seven (G-7) and so-called industrialized great eleven (G-11), which heretofore inappropriately, unnecessarily and inefficiently engage in imposing unauthorized assessments, alterations and manipulations of different so-called interest rate charges and fees on the debt balances withwithin a capital market of every and all obscurant, irresponsible, feculent, irrational, feckless, disrespectful, mendacious, ignorant, malicious, condescending, untruthful, insolent, inefficient, incognizant, ineffective, fragmenting, unlettered, unpolished, presumptuous, portentous, pretentious, fruitless, disparate, antiquated, archaic, ancient history and superannuated so-called developed and developing national sovereign free-market commerce and trade bloc economies within, throughout and transcending a single holistically econometric marketplace environment under guise of so-called setting forth their obfuscated malicious vision, veiled inopportune administration and predatory inapproprate management of the sustenance, growth and expansion of a single holistically econometric marketplace environment because they subsidize the largest portion of the funding of every and all obscurant, irresponsible, feculent, irrational, feckless, disrespectful, mendacious, ignorant, malicious, condescending, untruthful, insolent, inefficient, incognizant, ineffective, fragmenting, unlettered, unpolished, presumptuous, portentous, pretentious, fruitless, disparate, antiquated, archaic, ancient history and World Bank (WB) and the International Monetary Fund (IMF) inclusive of, without limitation, every and all obscurant, irresponsible, feculent, irrational, feckless, disrespectful, mendacious, ignorant, malicious, condescending, untruthful, insolent, inefficient, incognizant, ineffective, fragmenting, unlettered, unpolished, presumptuous, portentous, pretentious, fruitless, disparate, antiquated, archaic, ancient history and superannuated so-called divisions and departments therein, for example, the International Bank of Economic Reconstruction and Development (IBED). Within the so-called U.S., the so-called U.S. Federal Reserve Board of Governors, so-called U.S. Federal Open Market Committee and the so-called U.S. Federal Reserve Bank although in no small techniques, designs, systems, routines, devices, manners, modes, fashions, forms, formats, factors, objects, parts, segments, elements, components, constituents, ingredients, processes, methods and combinations premised on severely archaic legal basis and with no legally vested chartered power or authority whatsoever under the inefficient, ineffective, antiquated, archaic, ancient history and superannuated U.S. Federal Reserve Act of 1913 is present entrusted with exclusive regulatory oversight and supervisory responsibilities pertaining to the so-called U.S. banking system, and arbitrarily establishing the long-term monetary policy decisions formulated in the so-called U.S., itself a quasi-private, government affiliated, widely uncensured independent agency of the so-called U.S. government, not subject to the restrictions imposed on similar oriented independent agencies of the so-called U.S. government because of its apparently improper and potentially conflictive business initiatives, schemes, ocurrences, happenings, interactions, processes, methods, practices, movements, proceedings, messaging, presentations, notifications, filings, submissions, records, activities, actions, events, endeavors, tasks and affairs against the free-market private industry and sector oriented enterprises albeit they are member oriented banking institutions in the so-called U.S. banking system and international banking system. The so-called U.S. Federal Reserve Board of Governors, so-called U.S. Federal Open Market Committee and the so-called U.S. Federal Reserve Bank consists of twelve federal reserve banks, each one serving member banks located in various regions throughout the so-called U.S. while employing nearly 23,000 personnel employees, clearly categorizing it as one of the documented reference, logical scientific deduction and intuitive analytical reasoning that the premised on documented references dating back to an article in Barron's magazine published on Aug. 2, 1999 and furthermore premised strictly on logical scientific deduction reasoning that the twelve branches of the so-called U.S. Federal Reserve Bank serve are mere anachronisms of historical symbolic representation of the needs of the so-called U.S. banking system during the initial two centuries of the national sovereign existence of the so-called U.S. The so-called U.S. Federal Reserve Bank logically should not have separate federal reserve banks because it obviously contrary to the premise of its present false and misleading role as a so-called U.S. Central Bank in the so-called United States of America. Furthermore, every and all attempts to justify every and all requisite need for this overly influential and maliciously outspoken and arcane oriented false and misleading banking system logically undermined by the obvious premise that every and all transactional exchange initiatives which transpire in and comprise the essence of the inefficient, ineffective, dysfunctional and fragmented so-called U.S. banking system, inclusive of, without limitation, the aforementioned fragmenting capital market inefficiencies are transactional volumes or quantities effectuated via electronic means and devices with limited need for the costly marble-and-brass overhead and the overstaffed quantities of highly-paid personnel employees which heretofore consume the ancient history so-called U.S. Federal Reserve Board of Governors, ancient history so-called U.S. Federal Open Market Committee and the ancient history so-called U.S. Federal Reserve Bank. The present so-called U.S. banking system was devised by the Federal Reserve Act of 1913 to provide for the establishment of so-called U.S. Federal Reserve Bank, to furnish an elastic currency, to afford a means of rediscounting commercial paper, and to establish a more effective supervision of banking in the so-called U.S. The other present purposes for the existence of the so-called U.S. Federal Reserve Board of Governors and so-called U.S. Federal Reserve Bank include very obscure and unclear functions and responsibilities include distributing paper currency and coins, and providing banking services which range from check-clearing and electronically transportring funds between financial institutions via the present so-called Fed wire for a fee-rate, and also supervising member banks via regulation of loan reserve requirements which offer members of the Governors and so-called U.S. Federal Reserve Bank are premised on undeniable and evidentiary findings of fact, documented reference, logical scientific deduction and intuitive analytical reasoning promulgate every and all forms, formats, factors, ways, parts and segment which entail, encompass, comprise, involve, impact and/or effect continued and perpetual harming, damaging, inuring, insistent, insinuating, imposing, pestilent, impetuous, importune, pestiferous, condescending and insolent enthralling, hindering, entrapping, pretending, miring, fatiguing, maleficience, harassing, engulfing, pressing, malevolent, presuming, imprinting, malicious, suffocating, miring, strangling, repressing, entangling, pestering and oppressing individual members of the aforementioned UNIVERSAL POPULACE™ which are traditionally concretizing via inefficient, ineffective, dysfunctional and fragmented vast networks of antiquated, archaic, ancient history and superannuated aforementioned PUBLIC FINANCIALS™ organizations which heretofore continuously, arrogantly, imprudently, irrationally and irresponsibly engage in propagating aforementioned fragmenting capital market inefficiencies via the communicating conduits of conceptual aids within a single holistically econometric marketplace environment. Whereas, it is an undeniable and evidentiary findings of fact, documented reference, logical scientific reasoning and intuitive analytical reasoning that every and all of the aforementioned further involve, concern and pertain to every and all techniques, designs, systems, routines, devices, manners, modes, fashions, forms, formats, factors, objects, parts, segments, processes, methods which preclude the combination of PUBLIC FINANCIALS™ statements in connection with PUBLIC FINANCIALS™ instruments from members of the aforementioned UNIVERSAL POPULACE™ inclusive of, without limitation, aforementioned PUBLIC FINANCIALS™ instruments transactional exchange data with aforementioned PUBLIC FINANCIALS™ instruments transactional exchange information pertaining to every and all basic elemental developments, necessary interactions and integral transactional exchange initiatives, schemes, ocurrences, happenings, interactions, processes, methods, practices, movements, proceedings, messaging, presentations, notifications, filings, submissions, records, activities, actions, events, endeavors, tasks and affairs which are hereto discovered prevalent within an sector of the so-called U.S. economy and have evolved over time, and which further pertain to the so-called U.S. Federal Reserve Board of Governors and so-called U.S. Federal Reserve Bank entail establishing long-term monetary policy decisions for the so-called U.S. and providing liquidity to the banking system via Federal Open Market Committee actions and proceedings. Since the passing of the so-called Federal Reserve Act of 1913, although every and all techniques, designs, systems, routines, devices, manners, modes, fashions, forms, formats, factors, objects, parts, segments, elements, components, constituents, ingredients, processes, methods and combinations of processing check draft clearing services, distributing paper currency and coins, and transportring funds to commercial and merchant banks, savings and loans, credit unions, and thrift organizations involved in the banking sector have adapted to radical changes which have promulgated the m-called U.S. into the present new millennium, there have been literally no adaptations, technological innovations and/or public policy affairs and agendas initiated to promulgate massive consolidated and/or fully capacity restructuring of the ancient history so-called U.S. Federal Reserve Board of Governors, ancient history so-called U.S. Federal Open Market Committee and the ancient history so-called U.S. Federal Reserve Bank, irrespective of the fact that its present structural foundation, business oriented commerce driven initiatives, schemes, ocurrences, happenings, interactions, processes, methods, practices, movements, proceedings, messaging, presentations, notifications, filings, submissions, records, activities, actions, events, endeavors, tasks and affairs, and public policy actions and proceedings inclusive of, without limitation, its regulatory oversight and supervisory responsibilities, directly and indirectly, impact aforementioned fragmenting capital market inefficiencies inclusive of, without limitation, direct and indirect, impacts which it imposes on the economies of most sovereign nations from around the world. The archaic and logically outdated Federal Reserve Act of 1913 stipulated that premised on the national development of the so-called U.S. applicable to the respective time period of its enactment, that the so-called U.S. federal banking system consist of twelve federally chartered corporations, know as the so-called U.S. Federal Reserve Banks, in addition to the agency in Washington, D.C. with twelve so-called branches within, throughout and transcendin the so-called states of from its Reserve Bank. The innovative and technologically panacean cutting-edge innovative developments and technological advancements which have found their way to the so-called U.S. civilized economic marketplace environment over the last eighty-four years certainly undermine the requisite letter, spirit and nature for maintaining the twelve federally chartered corporations or subsidizing their operating expenses with fee-based charges and services which clearly intervene with the free-market private enterprises involved in maintaining a sound, liquid, and effective banking sector for the so-called U.S. In contrast to arcane understanding from most members of the aforementioned UNIVERSAL POPULACE™ that processing of wire transport of funds and clearing of check draft payment services by the so-called U.S. Federal Reserve Board of Governors and so-called U.S. Federal Reserve Bank clearly oversteps the boundaries of the mission and function, inclusive of the aim, letter, nature, breadth, sound, depth and scope of an independent agency of the so-called U.S. federal government. Whereas, legal evidence of this legal patent disclosure and legal patent document evinces a realitistic findings of fact, documented specificities and logical scientific deduction whereby every and all existance of aforementioned UCMOST™ information technology is immediately available as assurance of the capacity to supplant the frivolous, feculent and feckless onset of the wire jack line and/or wireless inefficient, portentous and fruitless so-called Internet in connection and/or combination with the inefficient, portentous and fruitless so-called World Wide Web. Whereas, it is an undeniable and evidentiary findings of fact, documented reference, logical scientific deduction and intutive analytical reasoning that none of the aforementioned fragmented capital market inefficiencies should be allowed to continue prevailing in perpetually harming, damaging, inuring, insistent, insinuating, imposing, pestilent, impetuous, importune, pestiferous, condescending and insolent enthralling, hindering, entrapping, pretending, miring, fatiguing, maleficience, harassing, engulfing, pressing, malevolent, presuming, imprinting, malicious, suffocating, miring, strangling, repressing, entangling, pestering and oppressing individual members of the aforementioned UNIVERSAL POPULACE™ which are traditionally concretizing via inefficient, ineffective, dysfunctional and fragmented vast networks of antiquated, archaic, ancient history and superannuated aforementioned PUBLIC FINANCIALS™ inefficiencies via communicating conduits of conceptual aids within a single holistically econometric marketplace environment. The so-called Federal Reserve Board, which is responsible for every and all oversight and supervision of the twelve federally chartered bank corporations, inclusive without limitation, of the separate independent agency known as the so-called U.S. Federal Reserve, is present involved in supposedly supplying liquidity to the so-called U.S. banking system via the Federal Open Market Committee actions and promulgating long-term monetary policy decisions for the so-called U.S., has one chairman and a seven-member board of governors. The so-called presiding chairman and present presiding seven-member board of governors are appointed by the so-called U.S. President and approved and/or ratified via consent and/or assent by the Senate of the so-called U.S. Congress. Whereas, it is an undeniable and evidentiary findings of fact, documented reference, logical scientific deduction and intuitive analytical reasoning that the president's of these twelve federally chartered bank corporations are over-paid in comparison with other independent agencies which are involved in supervising and regulating the banking sector in the so-called U.S., because they are not restricted to the limits imposed on federal personnel employment salaries. Thus, the chairman and the seven-member board of governors receive less personnel employment compensation that the bank president's of the twelve federally chartered bank corporations that encompass the twelve archaic so-called U.S. Federal Reserve Banks. Furthermore, because of there is no federally capped restrictions on the personnel employment salaries at the Federal Reserve Banks these officers of these twelve banks whose number has risen from 866 in 1986 to 1,024 as of 1998, receive many benefits which otherwise would never be afforded to government entity personnel employees irrespective of whether or not they are, directly or indirectly, affiliated as independent agencies of the so-called U.S. government. Because of these lack of cap salaried restrictions of Federal Reserve Bank president's their income from wages as of the publication of the aforementioned article ranged from $282,500 to US$193,000 whereas in comparison the income from wages requisitioned for the Federal Reserve Board governors and its chairman were approximately US$125,900 and US$136,700. A study conducted by the General Accounting Office (GAO) of the so-called U.S. Congress identified that such allotments forms of allotments identified at the counterpart agency, the so-called U.S. Securities and Exchange Commission (SEC). Furthermore, apparently the Federal Reserve Bank president's maintain high-profile research departments wherein the bank president's appear to compete with one another with glossy publications, resolveed with articles on topics, subjects, issues and matters far removed from the present policies supposedly promulgated by the so-called U.S. Federal Reserve Board of Governors via the Federal Open Market Committee (FOMC) initiatives, schemes, ocurrences, happenings, interactions, processes, methods, practices, movements, proceedings, messaging, presentations, notifications, filings, submissions, records, activities, actions, events, endeavors, tasks and affairs, actions and proceedings addressing aspects, topics, issues, matters, elements, components, functions, devices, software, systems, methods, combinations, processes and procedures which may provide every and all potential, albeit unlikely, justifiable basis and logical reasoning for the long-term monetary policy decisions for the so-called U.S. and utilization of additional so-called finny money liquid currency directly subsidized by so-called U.S. depositors and so-called U.S. citizen taxpayers to the so-called U.S. banking sector via arbitrarily issuing paper oriented bills, notes and bonds with the so-called U.S. government seal and approval. Furthermore, these titled articles do not even appear to address topics, subjects, issues and matters or provide every and all justifiable basis and logical reasoning for the banking oriented transactional exchange and clearing services present provided by these federally chartered corporate banks in direct competition with the so-called U.S. banking industry and sector. The following examples of the titled articles include topics, subjects, issues and matters which are very obscure and research oriented publications that appear to be academic journal type publications, albeit they are being authored, published and disseminated by the so-called U.S. Federal Reserve Bank officers, include the following, women in economics, seeking a blueprint for economic literary, a primer on moral-hazard models, wages and risk-taking in occupational credit unions: theory and evidence, small business finance in two Chicago minority neighborhoods, and the role and value of market forces authored by an actual bank president's wherein the bank president going on to reference that as a function of the position initiatives, schemes, ocurrences, events, endeavors, tasks and affairs, the president had been thinking about economic growth and, specifically, about those obscure factors that account for the sustenance of positive performance of the so-called U.S. economy over the past several years, but that as of the date of publication had not been able to arrive at a fully satisfactory explanation for growth in the so-called U.S. other than to note that at the present stage the analysis emphasized the value and significance of market forces, etc. Clearly these are the forms and types of research oriented topics, subjects, issues and matters conducted by vast numbers of economists employed in a university setting and think tanks throughout the so-called U.S. and the world, and thus as evidenced in the titled articles do not appear to address, focus or offer any forms, parts, means or segments to offer every and all forms of justifiable basis and logical scientific deduction reasoning for the present existence of the structural foundation, functional operations, transactional exchange initiatives, and therein potential importance of, or lack thereof, the present International Monetary Banking System, with specific focus on the ancient history so-called U.S. Federal Reserve Board of Governors, ancient history so-called U.S. Federal Open Market Committee and the ancient history so-called U.S. Federal Reserve Bank inclusive of, without limitation, its role and function in the so-called U.S. banking system, the so-called U.S. economy, the aforementioned fragmenting capital market inefficiencies premised specifically on the undeniable and evidentiary findings that the global economy lacks every and all techniques, designs, systems, routines, devices, manners, modes, fashions, forms, formats, factors, objects, parts, segments, elements, components, constituents, ingredients, processes, methods and combinations of applied information technology to mitigate the heretofore inefficient, ineffective, dysfunctional and fragmented state of the banking system found prevalent therein. Interestingly, childhood like and illogical justification and reasoning for not requisitioning massive consolidation of the so-called U.S. Federal Reserve Bank structural foundation, functional operations, transactional exchange initiatives, and therein potential importance of, or lack thereof, the present International Monetary Banking System, and thereby restricting the bank services the so-called U.S. Federal Reserve Bank performs in its inappropriate competition with free-market private sector banking organizations in performing said check-clearing and Reserve Bank Board of Governors. Thereupon, it has been referenced that streamlining the so-called U.S. Federal Reserve Board of Governors and so-called U.S. Federal Reserve Bank structural foundation, functional operations, transactional exchange intiatives, schemes, ocurrences, happenings, interactions, processes, methods, practices, movements, proceedings, messaging, presentations, notifications, filings, submissions, records, activities, actions, events, endeavors, tasks and affairs inclusive, without limitation, censuring its communicative capacity and eradicating its obscure and inevidentiary regulatory oversight and supervision responsibilities would shrink the number of people who serve on the board of directors of these federally chartered banking corporations wherein the present chairman has further been quoted as saying that the information supplied about local conditions by the directors of the twelve inefficient, ineffective, dysfunctional and fragmented federally chartered banking corporations has been frequently useful because supposedly these directors represent local labor, consumer and business interests in their communities. Clearly, there are more actively operational and subsidized federally chartered banking corporations in existence in the present so-called U.S. banking system than are logically necessary and ay and all governor and bank president positions on the highly obscure albeit so-called all important FOMC, which heretofore is made up of the chairman, seven board governors and five bank president's from twelve federally chartered bank corporations can be more seamless, efficient, effective, functional and integrated with application of every and all available technological resources. Apparently, the president of the New York based so-called U.S. Federal Reserve Bank serves on the FOMC on a continuous basis and with rotating membership of the remaining four bank president seats on the so-called U.S. Federal Reserve Board of Governors being selected from among the remaining eleven so-called U.S. Federal Reserve Banks from around the so-called U.S. Present under the feculent notion and feckless actions and proceedings of establishing long-term monetary policy decisions for the so-called U.S., the ancient history so-called U.S. Federal Reserve Board of Governors, ancient history so-called U.S. Federal Open Market Committee and the ancient history so-called U.S. Federal Reserve Bank arbitrarily fixes the Federal Funds Rate which is intrinsically the discount rate charges that represent the interest rate savings and commercial oriented accounts make up the heretofore majority circulating throughout the so-called U.S. This is in direct contrast to the bidding process utilized by the so-called U.S. Department of the Treasury to identify the present value of future cash flows on Treasury bills, notes and bonds when suchaforementioned PUBLIC FINANCIALS™ instruments are auctioned off in interval periods of each month, wherein the same large-scale member banking institutions of the so-called U.S. banking system continuously participate to afford the so-called U.S. government the capacity to deplete the amount of so-called U.S. currency present available in circulation throughout the so-called U.S. economy, the aforementioned fragmenting capital market inefficiencies. Ironcially, although it is the so-called U.S. Treasury Department's responsibility to auction off via a bidding process every and all obscurant, irresponsible, feculent, irrational, feckless, disrespectful, mendacious, ignorant, malicious, condescending, untruthful, insolent, inefficient, incognizant, ineffective, fragmenting, unlettered, unpolished, presumptuous, portentous, pretentious, fruitless, disparate, antiquated, archaic, ancient history and superannuated so-called U.S. Treasury bills, notes and bonds, which inevitably identify the cost of capital utilized to value these so-called default free public aforementioned PUBLIC FINANCIALS™ instruments financial transactional exchange instruments the ancient history so-called U.S. Federal Reserve Board of Governors, ancient history so-called U.S. Federal Open Market Committee and the ancient history so-called U.S. Federal Reserve Bank via FOMC initiatives, schemes, ocurrences, happenings, interactions, processes, methods, practices, movements, proceedings, messaging, presentations, notifications, filings, submissions, records, activities, actions, events, endeavors, tasks and affairs, believes albeit with no legally charter right or logical justifiable reasoning, it has the indepently vested authority and exclusive arbitrary power to contradict the open-market auctioned off bidding processes of the so-called U.S. Treasury Department with obscure, feculent and feckless initiatives, schemes, ocurrences, happenings, interactions, processes, methods, practices, movements, proceedings, messaging, presentations, notifications, filings, submissions, records, activities, actions, events, endeavors, tasks and affairs, actions and proceedings which supposedly enble it to fix or peg the discount rate or interest rate (hereafter to borrow overnight funds to cover every and all escrow and demand deposits beyond their loan reserves already on hand within these banking related members of the aforementioned UNIVERSAL POPULACE™. As further evidence of the importance of the innovative and technological utility engineering and architectural design propagations universal microprocessor computing design provisions embodied in the invention aforementioned UCMOST™ information technology in assisting members of the aforementioned UNIVERSAL POPULACE™ to seamlessly and naturally effectuating efficient, effective, streamlined, objective, well-informed, risk-managed and self-assured aforementioned PUBLIC FINANCIALS™ instruments transactional exchange decision initiatives, schemes, ocurrences, happenings, interactions, processes, methods, practices, movements, proceedings, messaging, presentations, notifications, filings, submissions, records, activities, actions, events, endeavors, tasks and affairs in protecting, sustaining and expanding their treasure accounting, financial fueling and econometric energizing in the present highly volatile, dysfunctional, fragmented and disintegrated aforementioned fragmenting capital market inefficiencies, it was reported within an article published in the business section of the Miami Herald dated Feb. 1, 2001, that the so-called U.S. Department of Treasury completed the final auction of the forty-two year of the so-called U.S. one-year Treasury bill, one of the most prolificaforementioned PUBLIC FINANCIALS™ instruments in the world, wherein the so-called U.S. Department of Treasury had previously already abstaned from auctioning sales of the one-year so-called U.S. Treasury bills from one a month to one every three months. In addition to enacting the immediate obsolescence of the widely recognized and worldwide prolific one-year Treasury bill to enable the so-called U.S. government to eliminate nearly US$20 billion in debt issuance in the year ending 2001, the so-called U.S. Department of Treasury has eliminated the previously auctioned sales of the three-year and seven-year so-called U.S. Treasury notes, while no comments on the elimination of the ten-year and thirty-year so-called U.S. Treasury bonds have been anounced. It was further reported that as a direct function of the so-called U.S. government's reduction in borrowing capital by auctioned sales aforementioned PUBLIC FINANCIALS™ instruments, the so-called U.S. Department of Treasury, which heretofore manages the US$3.4 trillion in so-called U.S. aforementioned PUBLIC FINANCIALS™ instruments that are heretofore outstanding and owned by members of the aforementioned UNIVERSAL POPULACE™ with aforementioned fragmenting capital market inefficiencies. The so-called U.S. Federal Reserve Board of Governors, so-called U.S. Federal Open Market Committee and the so-called U.S. Federal Reserve Bank via FOMC initiatives, schemes, ocurrences, happenings, interactions, processes, methods, practices, movements, proceedings, messaging, presentations, notifications, filings, submissions, records, activities, actions, events, endeavors, tasks and affairs, actions and proceedings with aforementioned fragmenting capital market inefficiencies is duplicating the so-called U.S. Treasury Department's open-market auction oriented free-market processes with arbitrary fixing of the cost of capital which serves as the basis for valuing every and all other aforementioned PUBLIC FINANCIALS™ instruments in direct contrast to the findings of fact, documented reference and logically justified reasoning which promulgated the so-called U.S. subsequent to the financial crises of the 1970's to eradicate the notion of fixing the economic units sum in monetary so-called U.S. dollar denomination to the quantities of gold reserves in the so-called U.S., the so-called gold standard. This tempestuous exponentially detrimental and inappropriate practice was initially promulgated during the nineteenth century when the British government fixed the value of its economic unit sum in monetary pound dollars to the quantities of sterling reserves available in that national sovereignty in Europe, the so-called silver standard. The comparison of the ancient history so-called U.S. Federal Reserve Board of Governors, ancient history so-called U.S. Federal Open Market Committee and the ancient history so-called U.S. Federal Reserve Bank feculent notion and feckless actions and proceedings of fixing or pegging the short-term Federal Funds Rate, which member banking institutions in the so-called U.S. banking system utilize to lend one another overnight currency to cover potential albeit not concretizing escrow and demand deposits requisition disbursements from members of the aforementioned UNIVERSAL POPULACE™, to the fixing or pegging of the so-called U.S. dollar and the British pound dollar historically to the quantities of gold and silver reserves respectively available to these sovereign nations during that time in history may not appear evidently single holistically econometric marketplace environment. This is potentially obscure to the untrained eye members of the aforementioned UNIVERSAL POPULACE™ becomes an undeniable and evidentiary findings of fact, documented reference and logically justifiable reasoning when associatively represented and prudently conceptualized in the context that with aforementioned fragmenting capital market inefficiencies irrespective of their present inefficient, ineffective, dysfunctional and fragmented letter, spirit, nature and structure the aforementioned PUBLIC FINANCIALS™ instruments exchanged among members of the aforementioned UNIVERSAL POPULACE™ which inevitably participate within these marketplace environments, continuously appreciate and depreciate over an indefinite period of time, but are strictly and exclusively premised on and take the form of competitive market forces representative of supply and demand for the given instrument among members of the aforementioned UNIVERSAL POPULACE™ and members of the aforementioned UNIVERSAL POPULACE™ which collectively encompass the members of the aforementioned UNIVERSAL POPULACE™ and citizens members of the aforementioned UNIVERSAL POPULACE™ of every and all sovereign nations from around the world. Thereupon, when this undeniable and evidentiary findings of fact, documented reference and logically justifiable reasoning is accounted for in its entire associative representation and proper conceptualization it can further be deduced and justified as a widely accepted public acknowledgement that the expectations, anticipations, hopes and fears members of the aforementioned UNIVERSAL POPULACE™ are comprehensively suitable, generally pertinent and broadly useful to the reporting of accurate, timely, reliable and verifiable every and all real-time processing and/or reprocessing of data and/or information receiver of the competitive forces of supply and demand for the givenaforementioned PUBLIC FINANCIALS™ instruments is the sole and exclusive premise which therein derives members of the aforementioned UNIVERSAL POPULACE™ preferential interests in their chosen selection of one aforementioned PUBLIC FINANCIALS™ instruments over another with aforementioned fragmenting capital market inefficiencies. This clearly evinces that several potential topics, subjects, issues and matters far removed from the present policies supposedly promulgated by the proceedings, messaging, presentations, notifications, filings, submissions, records, activities, actions, events, endeavors, tasks and affairs, actions and proceedings addressing every and all aspects, topics, issues, matters, elements, components, functions, devices, software, systems, methods, combinations, processes and procedures which may provide justifiable reasoning for the long-term monetary policy decisions for the so-called U.S. and utilization of additional currency liquidity to the so-called U.S. banking sector via arbitrarily issuing paper notes and bonds with the so-called U.S. government seal and approval, may clearly evince via logical observation and scientific deductive reasoning that over the eighty-four years of its existence the ancient history so-called U.S. Federal Reserve Board of Governors, ancient history so-called U.S. Federal Open Market Committee and the ancient history so-called U.S. Federal Reserve Bank inclusive of, without limitation, the extremely obscure feculent notions and feckless practices which it undertakes under the guise of a Federal Open Market Committee are potentially predatory unfair trade practices utilized exclusively as a leveraged albeit ungranted historical strong-hold and power of enthrallment and regulatory authority over the so-called U.S. economy and global economy inclusive, without limitation, raise evidentiary appearance of improprieties, and conflicts of interests of this so-called independent agency of the so-called U.S. with limited justification and logical reasoning for existence in the first place. Interestingly, it was recently reported within an article in a Miami Herald publications dated February 2000, that the so-called U.S. Department of Treasury in concert with the so-called U.S. Office of the Controller of the Currency has authorized the elimination of the existence of the so-called U.S. Treasury bills, notes and bonds which have historically been auctioned off in a bidding process to reduce the interest payments made on these so-called U.S. government debt aforementioned PUBLIC FINANCIALS™ instruments to assist so-called U.S. depositors and so-called U.S. citizen taxpayers in eliminating the so-called U.S. national debt which is continuously tempestuous exponentially detrimental to the treasure accounting, financial fueling and econometric energizing of the United States in an highly volatile and increasingly competitive global marketplace economy of a single holistically econometric marketplace environment. The so-called U.S. Federal Reserve Board of Governors, so-called U.S. with aforementioned fragmenting capital market inefficiencies as a device and means of adding or depleting, so-called funny money, liquid currency in the so-called U.S. economy and abroad by issuing paper oriented public aforementioned PUBLIC FINANCIALS™ instruments financial transactional exchange instrumnets. Additionally, the ancient history so-called U.S. Federal Reserve Board of Governors, ancient history so-called U.S. Federal Open Market Committee and the ancient history so-called U.S. Federal Reserve Bank utilizes these devices and means of regulating the loan reserve requirements bank lending institutions in the so-called U.S. are required to maintain in order to maintain a sustainable amount of liquidity in theirmembers of the aforementioned UNIVERSAL POPULACE™ inclusive of, without limitation, in the aggregate national bank lending system of the so-called U.S. Moreover, the ancient history so-called U.S. Federal Reserve Board of Governors, ancient history so-called U.S. Federal Open Market Committee and the ancient history so-called U.S. Federal Reserve Bank also utilizes regulatory oversight and supervision responsibilities over the twelve federally chartered corporate banks which, in turn supposedly provide regulatory oversight and supervision responsibilities over the member large-scale banking institutions which participate in offering demand deposit savings accounts to members of the aforementioned UNIVERSAL POPULACE™, members of the aforementioned UNIVERSAL POPULACE™. These various means of supposedly regulatory oversight and supervision responsibilities present utilized by the ancient history so-called U.S. Federal Reserve Board of Governors, ancient history so-called U.S. Federal Open Market Committee and the ancient history so-called U.S. Federal Reserve Bank inclusive of, without limitation, its obscure and questionable Federal Open Market Committee and twelve inefficient, ineffective, dysfunctional and fragmented so-called U.S. Federal Reserve Banks represent supposedly, without limitation, the primary device and means utilized so-called U.S. government to ensure the liquidity, solvency and effectiveness of the so-called U.S. banking system inclusive of, without limitation, the long-term monetary policy decision making processes of the so-called U.S. It is an present undeniable and evidentiary findings of fact, documented reference, logical scientific deduction and intuitive analytical reasoning, and moreover widely recognized among so-Federal Reserve Board of Governors, ancient history so-called U.S. Federal Open Market Committee and the ancient history so-called U.S. Federal Reserve Bank supposedly utilizes a variety of hypothetical average statistically inferred economic activity-based measurements to form the premise for obscurely justifying its feculent notions and feckless practices undertaken under the guise of a Federal Open Market Committee to fix or peg the short-term Federal Funds Rate, and effectuate the long-term monetary policy decisions in the so-called U.S. which, directly and indirectly, impact the aforementioned PUBLIC FINANCIALS™ instruments transactional exchange data with aforementioned PUBLIC FINANCIALS™ instruments transactional exchange information with aforementioned fragmenting capital market inefficiencies on a day-to-day basis which is ludicrously in direct contrast to prudent manage of long-term monetary policy decision-making for every and all sovereign national economies which inevitably participate with aforementioned fagmenting capital market inefficiencies. Th predominately referenced hypothetical average statistically inferred economic activity-based measurements utilized by the ancient history so-called U.S. Federal Reserve Board of Governors, ancient history so-called U.S. Federal Open Market Committee and the ancient history so-called U.S. Federal Reserve Bank to form the premise for obscurely justifying its feculent notions and feckless practices undertaken under the guise of a Federal Open Market Committee to present fix the short-term Federal Funds Rate, and present effectuate the long-term monetary policy decisions in the so-called U.S. include, without limitation, the Producers Price Index (PPI) generated by the National Association of Purchasing Mangers (NAPM); the Consumer Price Index (CPI) generated by the so-called U.S. Bureau of Economic Analysis (BEA); and the Employment Index generated by the so-called U.S. Department of Labor (USDOL) each of which respectively identify the level and rates of growth of the cost of goods sold supposedly concretizing in the factors of production, the expectations, anticipations, hopes and fears of so-called U.S. citizen taxpayers premised on the sales of merchandising products, goods, supplies and services, and the employment applications filed by so-called U.S. citizen taxpayers. Other such hypothetical average statistically inferred economic activity-based measurements utilized by the ancient history so-called U.S. Federal Reserve Board of Governors, ancient history and feckless practices undertaken under the guise of a Federal Open Market Committee to present fix the short-term Federal Funds Rate, and present effectuate the long-term monetary policy decisions in the so-called U.S. include, without limitation, constructions development activity, heating oil and gas valuations, and aggregate composite earnings forecasts of the members of the aforementioned UNIVERSAL POPULACE™ which inevitably participate with aforementioned fragmenting capital market inefficiencies and which thereupon register as either domestic enterprises of bank issued ADR's with the so-called U.S. SEC and subsequently list their public enterprise aforementioned PUBLIC FINANCIALS™ instruments with licensed so-called U.s. securities exchange, such as the NYSE and/or NASDAQ, the AMEX and/or ECN's. Further, the hypothetical average statistically inferred economic activity-based measurements utilized by the ancient history so-called U.S. Federal Reserve Board of Governors, ancient history so-called U.S. Federal Open Market Committee and the ancient history so-called U.S. Federal Reserve Bank include, without limitation, the Gross National Product and Gross Domestic Product. The Gross National Product is the total final value of all merchandising products, goods, supplies and services of a particular sovereign nation. The Gross Domestic Product is the total value of merchandising products, goods, supplies and services of a particular sovereign nation. Ironically, the ancient history so-called U.S. Federal Reserve Board of Governors, ancient history so-called U.S. Federal Open Market Committee and the ancient history so-called U.S. Federal Reserve Bank premised on its evidentiary obscure, feculent notion, and feckless practice of leveraging the FOMC to fix or peg the short-term Federal Funds Rate and establish long-term cash money currency in the so-called U.S. albeit it is clearly an undeniable and evidentiary findings of fact, documented reference and logical justifiable reasoning that this responsibility was never a form, part, means and segment of the ancient history so-called U.S. Federal Reserve Board of Governors, ancient history so-called U.S. Federal Open Market Committee and the ancient history so-called U.S. Federal Reserve Bank legal charter under the Federal Reserve Act of 1913 inclusive of, without limitation, its continuous pursuit of the increase and/or depletion the money supply of so-called U.S. currency into the so-called U.S. economy and global economy utilizes these various obscure means of supposedly and supervision responsibility in a futile endeavor of attempting to gauge the levels and rates of growth of so-called U.S. currency in the so-called U.S. economy in relation to the levels of employment in the so-called U.S. economy. It is a clear and undeniably findings of fact, documented reference, logical scientific deduction and intuitive analytical reasoning that the heretofore feculent and feckless blind fold oriented and fly-from-the-hip hypothetical averaged statistically inference based decision-making processes are completely illogical, unreasonable, unjustifiable and archaic in their letter, spirit, nature, scope, breadth and depth in any form, but even more so when attempting to management the growth or lack thereof of a so-called sovereign national economy which is exclusively service, entertainment and tourism driven whence hereafter entering a new millenium which with melioristic logical positivism rubric isomorphic transmutting paradigm shift toward unreproachable UCMOST information technologies wlch are unequivocally and independently capable of implementing innovative and technologically panacean cutting-edge innovative developments and technological advancements to ascertain timely, accurate, reliable and verifiable automatizing real-time holistically steady state synchronized ubiquitous continuous uptime real-time automatizing real-time holistically steady state synchronized ubiquitous continuous uptime real-time automatizing real-time transmission propagating transporting transmuting partible beta particle beam gliding transponder converting receiver conduit aforementioned UCMOST™ real-time processing and/or reprocessing of every and all data and/or information involving content management, financial services and aforementioned PUBLIC FINANCIALS instrument transactional exchange decision initiatives, schemes, ocurrences, happenings, interactions, processes, methods, practices, movements, proceedings, messaging, presentations, notifications, filings, submissions, records, activities, actions, events, endeavors, tasks and affairs on behalf of hundreds of millions of individual members of the aforementioned UNIVERSAL POPULACE. Furthermore, premised on the feculent notion and feckless practices of bombarding members of the aforementioned UNIVERSAL POPULACE™ with manipulative fears of unsubstantiated justifiable basis and logical scientific deduction reasong for guaging the what may be considered stagflation, recession, inflation or deflation in the so-called U.S. which the so-called U.S. Federal Reseve Board of Governors and so-called U.S. Federal Reserve Bank enthrall the so-called U.S. congress, so-called U.S. economy, the aforementioned fragmenting capital market inefficiencies and the so-called U.S. worldwide UNIVERSAL CAPITAL MARKET™s it is reported within an article published in the Miami Herald dated Mar. 1, 2001, that the chairman of the present so-called U.S. Federal Reserve Board of Governors and so-called U.S. Federal Reserve Bank testified before the so-called U.S. congresses House Financial Services Committee wherein he directly contradicted his previous testimony offered to the so-called U.S. congresses Senate Banking Committee two weeks prior thereto, that he as the chairman of the present so-called U.S. Federal Reserve Board of Governors and so-called U.S. Federal Reserve Bank expresses new worries that the so-called U.S. economic slowdown has yet to run its full course while obscurely signaling that the present so-called U.S. Federal Reserve Board of Governors and so-called U.S. Federal Reserve Bank is ready at its exclusive and arbitrary will to downwardly adjust the Federal Funds Rate once again to promulgate the appearance of manipulative growth in transactional exchange initiatives in the so-called U.S. economy via the present Federal Open Market Committee undertaking, actions and processes. Furthermore, the chairman of the ancient history so-called U.S. Federal Reserve Board of Governors, ancient history so-called U.S. Federal Open Market Committee and the ancient history so-called U.S. Federal Reserve Bank speculated once again that his beliefare comprehensively suitable, generally pertinent and broadly useful to the apparent presumptuous speculative and most likely ill-conceived notion of a downturn in so-called U.S. economic transactional activity, which may be logically deduced from the fact that therir is a complete lack of information technology applied to every and all industries and sectors of the so-called U.S. economy which could potentially evince such realities in the future with hard every and all real-time processing and/or reprocessing of data and/or information receiver, is that members of the aforementioned UNIVERSAL POPULACE™ are working arbitrarily to align his so-called speculative notions of excess inventories with his so-called speculative notions of demand in the so-called U.S. economy. Moreover, the chairman of the ancient history so-called U.S. Federal Reserve Board of Governors, ancient history so-called U.S. Market Committee have historically altered the Federal Funds Rate in between their scheduled meetings, which have ironically never been publicly availalbe, and at their exclusive and arbitrary will may once again act in manipulating the growth of the so-called U.S. economy by once again altering downwardly the Federal Funds Rate. Interestingly, and in direct contrast to evindentiary findings of fact, documented reference, logical scientific deduction reasoning are comprehensively suitable, generally pertinent and broadly useful to the arbitrary will and tyrannical enthrallment over the aforementioned fragmenting capital market inefficiencies and so-called U.S. economy, the chairman of the ancient history so-called U.S. Federal Reserve Board of Governors, ancient history so-called U.S. Federal Open Market Committee and the ancient history so-called U.S. Federal Reserve Bank stated that the exceptional albeit speculative and so-called slowdown in the so-called U.S. economy as of year ending 2000 in his beliefand best understanding a simple consequence of adverse weather climate. This is quite an inappropriate and condescending statement which has no justifiable sustenance in light of the undeniable and evidentiary findings of fact, documented reference, logical scientific deduction and intuitive analytical reasoning which concludes that the so-called U.S. is present a transactional oriented economy driven by information technology and productivity gains pertaining to the exchange of products, goods, supplies and services. Furthermore, the chairman stated that one of the biggest factors he and the present so-called U.S. Federal Reserve Board of Governors, Federal Open Market Committee, and so-called U.S. Federal Reserve Bank utilize to exclusively and arbitrarily at wil alter, change and ajust to Federal Funds Rate to tout the appearance of growth as a manipulative attempt at sparking transactional activity in the so-called U.S. economy wherefrom hereto undeniably promulgates every and all forms, formats, factors, way, means, parts and segments entailing, encompassing, comprising, involving, impacting and/or effecting continued and perpetual harming, damaging, inuring, insistent, insinuating, imposing, pestilent, impetuous, importune, pestiferous, condescending and insolent enthralling, hindering, entrapping, pretending, miring, fatiguing, maleficience, harassing, engulfing, pressing, malevolent, presuming, imprinting, malicious, suffocating, miring, strangling, repressing, entangling, pestering and oppressing individual members archaic, ancient history and superannuated aforementioned PUBLIC FINANCIALS™ organizations which heretofore continuously, arrogantly, imprudently, irrationally and irresponsibly engage in propagating aforementioned fragmenting capital market inefficiencies via the communicating conduits of conceptual aids. The chariman of the so-called U.S. Federal Reserve Board of Governors, so-called U.S. Federal Open Market Committee, and so-called U.S. Federal Reserve Bank was also reported in the article published in the Miami Herald dated Mar. 1, 2001, as stating, albeit in direct contrast to the evidentiary findings of fact and documented reference of the present so-called U.S. Federal Reserve Board of Governors, Federal Open Market Committee, and so-called U.S. Federal Reserve Bank, that the one single thing he apparently knows for a fact is that you cannot spin the economy in one direction or the other because it doesn't work, Furthermore, the chairman of the so-called U.S. Federal Reserve Board of Governors, Federal Open Market Committee and so-called U.S. Federal Reserve Bank stated that he believes it is too early for him to exclusively and arbitrarily at will serve as judge and jury over whether the exponential develuation inaforementioned PUBLIC FINANCIALS™ instruments with aforementioned fragmenting capital market inefficiencies could lead to a recession in the so-called U.S. economy, because his so-called expert and obscure beliefs are inappropriate, unnecessary, unwelcome, illegal and/or comprehensively insuitable, generally impertinent and broadly useless to any and all valuation of aforementioned PUBLIC FINANCIALS™ instruments within the a single holistically econometric marketplace environment and simply proliferate and promulgate more of the aforementioned fragmenting capital market inefficiencies specifically in light of the undeniable and evidentiary findings of fact, documented reference, logical scientific deduction and intutively analytical reasoning thtat gains and losses from aforementioned PUBLIC FINANCIALS instruments inclusive of the sustenance, growth and expansion of the a single holistically econometric marketplace environment and the treasure accounting, financial fueling and econometric energizing of members of the aforementioned UNIVERSAL POPULACE is intrinsically a derivate function of factual data and information which is undeniably, logically, scientifically and intutively lacking everywhere within each and every sector and industry within, aforementioned UNIVERSAL POPULACE place place in the efficiency and effectiveness but most importantly the integrity and honor with which senior executives of aforementioned PUBLIC FINANCIALS™ organization within, throughout and transcending every and all multifacted sectors and multidimensional industries from the national sovereign industrialized, developed and developing free-market commerce and trade bloc economies of the global econometric marketplace envionrment not how wealthy people feel and their willingness to spend so-called currency monies a preconceived and irrefutably illogical notion the upwards of 66% of the economic activity of a single holistically econometric marketplace environment is exclusively due to consumer spending as speculatively, inappropriately, illogically and imprudently widely promulgated and publicized by the so-called U.S. Federal Board of Governors, so-called U.S. Federal Open Market Committee and the so-called U.S. Federal Reserve Bank. Whereas, it is an undeniable and evidentiary findings of fact, documented reference, logical scientific deduction and intuitive analytical reasoning that the overwhelmingly greater majority of the members of the aforementioned UNIVERSAL POPULACE are not wealthy and thus the speculatively, inappropriately, illogically and imprudently widely promulgated and publicized preconceived, antiquated, archaic, ancient history and superannuated notions of the so-called chairman of the heretofore so-called U.S. Federal Board of Governors, so-called U.S. Federal Open Market Committee and the so-called U.S. Federal Reserve Bank is herewith denounced entirely as lacking any and all merit and/or justifiable, logical, scientific and/or intutive basis, thus heretofore completely and perpetually harming, damaging, inuring, insistent, insinuating, imposing, pestilent, impetuous, importune, pestiferous, condescending and insolent enthralling, hindering, entrapping, pretending, miring, fatiguing, maleficience, harassing, engulfing, pressing, malevolent, presuming, imprinting, malicious, suffocating, miring, strangling, repressing, entangling, pestering and oppressing individual members of the aforementioned UNIVERSAL POPULACE™ by continuously, arrogantly, imprudently, irrationally and irresponsibly engage in propagating aforementioned fragmenting capital market inefficiencies via the communications to propagandize conceptual aids. Whereas, it is an undeniable and evidentiary findings of fact, documented reference, logical life, health, property, casualty, liabilities, valuables and/or factors, things, elements and/or courses of initiatives, schemes, ocurrences, happenings, interactions, processes, methods, practices, movements, proceedings, messaging, presentations, notifications, filings, submissions, records, activities, actions, events, endeavors, tasks and affairs and savings are heretofore continuously preyed upon by the vast network of intermediary banking, securities and insurance related members of the aforementioned UNIVERSAL POPULACE™ and their subsidiary sales commissioned account executives which heretofore enthrall members of the aforementioned UNIVERSAL POPULACE™ with heretofore aforementioned fragmenting capital market inefficiencies. Thus, it is an undeniable and evidentiary findings of fact, documented reference, logical scientific deduction and intuitive analytical reasoning that the so-called belief statements and best understanding of the heretofore so-called chairman of the heretofore so-called U.S. Federal Reserve Board of Governors, Federal Open Market Committee and so-called U.S. Federal Reserve Bank are hereto emphatically speculative, illogical, false, misleading, unnecessary, unwarranted and unjustifiable as taken under oath before the Senate Banking Committee and House Financial Services Committee of the so-called U.S. Congress, inclusive of, without limitation, wide-spread public press release to individual members of the aforementioned UNIVERSAL POPULACE™ because it is clearly an undeniable and evidentiary findings of fact, documented reference, logical scientific deduction and intuitive analytical reasoning that every and all individual members of the aforementioned UNIVERSAL POPULACE™ are logical participants engulfed, entrapped and opressed with aforementioned fragmenting capital market inefficiencies while necessarily having their cash liqudity, financial solveny and economic stability at stake with the capital market of a single holistically econometric marketplace environment due to their direct or indirect ownership aforementioned PUBLIC FINANCIALS™ instruments. Therewithal, it is an undeniable and evidentiary findings of fact, documented reference, logical scientific deduction and intuitive analytical reasoning that approximately half of all so-called U.S. families who reside in the so-called U.S. heretofore own some techniques, designs, systems, routines, devices, manners, modes, fashions, forms, formats, factors, objects, parts, segments, elements, transcending the capital market via direct and/or indirect participations and stakes at risk while being completely in the dark about the undeniably, logical, scientific and intutively understanding of the vast amounts of aforementioned fragmenting capital market inefficiencies, and this majority within the so-called U.S. is in fact that segment which entails labor related wage income earnings and necessarily effectuates the confidence of the societal population of the so-called U.S. and necessarily requires reasonable purchases which encompasses, without limitation, the large majority of the so-called speculative and preconceived notion of consumer spending, wherefrom given the limited wage income related earnings for labor related services to aforementioned PUBLIC FINANCIALS organizations are not wealthy as incorrectly stipulated by the heretofore so-called chairman of the heretofore so-called U.S. Federal Reserve Board of Governors, Federal Open Market Committee and so-called U.S. Federal Reserve Bank. Therein, supposedly albeit under a feculent notion and feckless practices in an clear attempt to steer the so-called U.S. economy inclusive of, without limitation, the global economies of all other sovereign nations throughout the world, the ancient history so-called U.S. Federal Reserve Board of Governors, ancient history so-called U.S. Federal Open Market Committee and the ancient history so-called U.S. Federal Reserve Bank arbitrarily impose member bank loan reserve requirements in the so-called U.S. banking system and/or utilization of FOMC purchases or sales aforementioned PUBLIC FINANCIALS™ instruments in the debt bond segment of an aforementioned efficient UNIVERSAL CAPITAL MARKET™. Within an article published in the Miami Herald dated Mar. 3, 2001, it was reported that in testifying before the so-called U.S. congress House Budget Committee downplayed the evidentiary findings of fact, documented reference, logical scientific deduction reasoning which clearly displays the present so-called U.S. Federal Reserve Board of Governors, its Federal Open Market Committee, and the so-called U.S. Federal Reserve Bank are inappropriately leveraged to alter, change and feculently and fecklessly attempt to control aforementioned fragmenting capital market inefficiencies under the guise of exclusively and arbitrarily establishing long-term monetary policy decisions for the so-called U.S. economy. Furthermore, premised on the fact that every and all long-term monetary policy decisions are impact every and all techniques, designs, systems, routines, devices, manners, modes, fashions, forms, formats, factors, objects, parts, segments, elements, components, constituents, ingredients, processes, methods and combinations of the so-called U.S. economy or eighteen to twenty-four months in any other economy in the industrialized, developing and developed sovereign nations of a single holistically econometric marketplace environment, the ancient history so-called U.S. Federal Reserve Board of Governors, ancient history so-called U.S. Federal Open Market Committee and the ancient history so-called U.S. Federal Reserve Bank have feculantly and fecklessly mistaken their present role, vested legal charter under the so-called U.S. Federal Reserve Act of 1913, supervisory oversight and regulatory authority over the so-called U.S. banking system in the so-called U.S. In display of their continuously day-to-day and month-to-month alterations, changes and faculent and feckless attempts at controlling aforementioned fragmenting capital market inefficiencies under the guise of exclusively and arbitrarily at will establishing long-term monetary policy decisions for the so-called U.S. economy, the present so-called U.S. Federal Reserve Board of Governors, its Federal Open Market Committee, and the so-called U.S. Federal Reserve Bank altered, changed and adjusted the Federal Funds Rate upward on six different occassions between June 1999 and May 2000, then once again exclusively and arbitrarily at will speculatively altered, changed and adjusted the Federal Funds Rate downward on two separate occassions during the month of January 2001. Whereas, it is an undeniable and evidentiary findings of fact, documented reference, logical scientific deduction and intuitive analytical reasoning that no more than eighteen months expired from the referenced start of the present so-called U.S. Federal Reserve Board of Governors, its Federal Open Market Committee, and the so-called U.S. Federal Reserve Bank exclusive and arbitrary at will speculative alteration, changes and adjustments to the Federal Funds Rates, while no more than six months expired from their speculative alteration, changes and adjustments effectuated in May of 2000. Furthermore, it is clearly an undeniable and evidentiary findings of fact, documented reference, logical scientific deduction and intuitive analytical reasoning that every and all speculative alternation, change and adjustment to the Federal Funds Rates in an attempt at manipulating the transactional submissions, records, activities, actions, events, endeavors, tasks and affairs which occur in the so-called U.S. economy, aforementioned fragmenting capital market inefficiencies is feculant and feckless in this limited expiration of time because every and all impacts on the so-called U.S. economy of the June 1999 alterations, changes and speculative adjustments would have taken at least until January 2001 to have any affect. During the expiration of the months of June 1999 and January 2001, the present so-called U.S. Federal Reserve Board of Governors, its Federal Open Market Committee and the. so-called U.S. Federal Reserve Bank effectuated exclusive and arbitrary at will speculative alterations, changes and adjustments to the Federal Funds Rates on six different occassions upwardly and two separate occassions downwardly offering tens of hundreds of thousands members of the aforementioned UNIVERSAL POPULACE™ and hundreds of millions members of the aforementioned UNIVERSAL POPULACE™ from around the world whereby as an undeniable and evidentiary findings of fact, documented reference, logical scientific deduction and intuitive analytical reasoning evincing obscurant tactics which preclude members from acquiring an entire conceptual, clearly recognized and fill appreciation of the systematic feculent and feckless speculative manipulations of the present so-called U.S. Federal Reserve Board of Governors, its Federal Open Market Committee, and the so-called U.S. Federal Reserve Bank. Hereto, as of the month of February 2000, aforementioned fragmenting capital market inefficiencies have displayed exponential systematic volatility which has as an evidentiary findings of fact, documented reference, logical scientific deduction reasoning led to the tempestuous devaluation of most every and all aforementioned PUBLIC FINANCIALS™ instruments with aforementioned fragmenting capital market inefficiencies creating multiple trillions of so-called U.S. dollar equivalent losses for tens of hundreds of thousands members of the aforementioned UNIVERSAL POPULACE™ and hundreds of millions members of the aforementioned UNIVERSAL POPULACE™ from around the world. Whereas, it is an undeniable and evidentiary findings of fact, documented reference, logical scientific deduction and intuitive analytical reasoning that the present so-called U.S. Federal Reserve Board of Governors, its Federal Open Market Committee, and the so-called U.S. Federal Reserve Bank has no rational basis, logical utilizing every and all undertaking, actions or proceedings which entail transactional exchange initiatives, schemes, ocurrences, happenings, interactions, processes, methods, practices, movements, proceedings, messaging, presentations, notifications, filings, submissions, records, activities, actions, events, endeavors, tasks and affairs involving aforementioned PUBLIC FINANCIALS™ instruments and/or increase/decrease of loan reserve member bank related members of the aforementioned UNIVERSAL POPULACE™ in clearly a speculative, feculent, feckless, futile, inappropriate, undeniable, unnecessary, unwarranted, illogical, unjustifiable, tempestuous exponentially detrimental ad tempestuous exponentially debilitating attempt to manipulate the appreciation or depreciation of the value of appreciation and/or depreciation aforementioned PUBLIC FINANCIALS™ instruments with aforementioned fragmenting capital market inefficiencies inclusive of without limitation, every and all transactional exchange initiatives, schemes, ocurrences, happenings, interactions, processes, methods, practices, movements, proceedings, messaging, presentations, notifications, filings, submissions, records, activities, actions, events, endeavors, tasks and affairs which involve products, goods, supplies and services. Furthermore, the present so-called U.S. Federal Reserve Board of Governors, its Federal Open Market Committee, and the so-called U.S. Federal Reserve Bank actively pursues every and all of these undertaking, actions and proceedings and the under the guise of exclusively and arbitrarily at will establishing long-term monetary policy for the so-called U.S government, and this clearly promulgates continued and perpetual harming, damaging, inuring, insistent, insinuating, imposing, pestilent, impetuous, importune, pestiferous, condescending and insolent enthralling, hindering, entrapping, pretending, miring, fatiguing, maleficience, harassing, engulfing, pressing, malevolent, presuming, imprinting, malicious, suffocating, miring, strangling, repressing, entangling, pestering and oppressing individual members of the aforementioned UNIVERSAL POPULACE™ which are traditionally concretizing via inefficient, ineffective, dysfunctional and fragmented vast networks of antiquated, archaic, ancient history and superannuated aforementioned PUBLIC FINANCIALS™ organizations which heretofore continuously, arrogantly, imprudently, irrationally and irresponsibly engage in propagating aforementioned fragmenting capital market evidentiary findings of fact, documented reference, logical scientific reasoning and intuitive analytical reasoning that every and all of the aforementioned further involve, concern and pertain to further grasp, entire conceptualization, clear recognition and full apprecitiaon of how the so-called U.S. Federal Reserve Board of Governors and so-called U.S. Federal Reserve Bank arbitrarily and in feculent and feckless manner, methods and processes which involve alteration, changes and adjustments on a short-term basis of Federal Funds Rate policy decisions which directly and indirectly impact aforementioned fragmenting capital market inefficiencies under the guise of establishing long-term monetary policy decisions for the so-called U.S. government it must be associated that historically when a sovereign government buys debt bond oriented aforementioned PUBLIC FINANCIALS™ instruments it is addiing liquidity to the marketplace environment, and when it sells debt bond oriented aforementioned PUBLIC FINANCIALS™ instruments it is depleting liquidity in the marketplace environment. This aforementioned example is more associative to FOMC actions of purchase or sale aforementioned PUBLIC FINANCIALS™ instruments, but when the ancient history so-called U.S. Federal Reserve Board of Governors, ancient history so-called U.S. Federal Open Market Committee and the ancient history so-called U.S. Federal Reserve Bank arbitrarily impose changes to member bank loan reserve requirements in the so-called U.S. banking system it directly impacts the amount of money made available for borrowing by public/private organizations and members of the aforementioned UNIVERSAL POPULACE™ in the so-called U.S. economy, and therein subsequently if the adjustment is an increase in loan reserve requirements less money is made available to the marketplace hence limiting money supply and increasing the cost to borrow those limited amounts of capital. Furthermore, this increased borrowing costs assumed by members of the aforementioned UNIVERSAL POPULACE™ translates into tempestuous devaluation of debt bond oriented aforementioned PUBLIC FINANCIALS™ instruments with aforementioned fragmenting capital market inefficiencies because the value of a fixed payment debt bond aforementioned PUBLIC FINANCIALS™ instruments is adjusted inversely to the increase or decrease in the cost of capital or discount rate utilized to identify the present value of that specific PUBLIC Federal Reserve Bank chooses to increase/decrease the Federal Funds Rate and/or increase/decrease the loan reserve requirements of member banking organizations that participate in the highest levels of the so-called U.S. banking systems it is respectively increasing borrowing costs to public/private organizations leading to devalued stock equity oriented aforementioned PUBLIC FINANCIALS™ instruments with aforementioned fragmenting capital market inefficiencies, and increasing the borrowing costs by limiting the money supply available for member banking institutions to offer members of the aforementioned UNIVERSAL POPULACE™ loans and demand deposits thus leading to inverse tempestuous devaluation of debt bond oriented PUBLIC FINANCIALS™ instruments. Furthermore, by effectuating every and all purchase/increase and/or sale/restriction aforementioned PUBLIC FINANCIALS™ instruments via the FOMC initiatives, schemes, ocurrences, happenings, interactions, processes, methods, practices, movements, proceedings, messaging, presentations, notifications, filings, submissions, records, activities, actions, events, endeavors, tasks and affairs, actions and proceedings it is either increasing the money supply when purchasing these aforementioned PUBLIC FINANCIALS™ instruments which intrinsically driving down the borrowing costs to members of the aforementioned UNIVERSAL POPULACE™ and global inevstors, and increasing stock equity and debt bond oriented aforementioned PUBLIC FINANCIALS™ instruments or restricting the so-called U.S. dollar money supply in circulation in the global economy thus increasing borrowing costs to members of the aforementioned UNIVERSAL POPULACE™ which drives down earnings potential from members of the aforementioned UNIVERSAL POPULACE™ and thus leads to devaluation of stock equity aforementioned PUBLIC FINANCIALS™ instruments and leads to tempestuous devaluation of debt bond aforementioned PUBLIC FINANCIALS™ instruments because the future cash flows of said bond oriented instrument cause the present value of the aforementioned PUBLIC FINANCIALS™ instruments to move inversely to the increase in the borrowing costs due to restriction of the so-called U.S. dollar money supply in circulation in the global economy. Now, as the stock equity and debt bond aforementioned PUBLIC FINANCIALS™ instruments are intricately, directly and indirectly, a function of the cost every and all derivative aforementioned PUBLIC FINANCIALS™ instruments whose intrinsic values are a function of the stock equity and debt bond oriented aforementioned PUBLIC FINANCIALS™ instruments also appreciate or depreciate in relative value to the changes in valuation of the parent stock equity and debt bond aforementioned PUBLIC FINANCIALS™ instruments of which they are directly and/or indirectly, derivative and or synthetic functions of in determining their valuation. Moreover, as every and all stock equity and debt bond oriented aforementioned PUBLIC FINANCIALS™ instruments listed in most every and all of the W.W. capital markets from around the world every and all initiatives, schemes, ocurrences, happenings, interactions, processes, methods, practices, movements, proceedings, messaging, presentations, notifications, filings, submissions, records, activities, actions, events, endeavors, tasks and affairs, actions and/or proceedings from the ancient history so-called U.S. Federal Reserve Board of Governors, ancient history so-called U.S. Federal Open Market Committee and the ancient history so-called U.S. Federal Reserve Bank in an effort to seamlessly and naturally exclusively undertaken and arbitrary monetary policy decisions are comprehensively suitable, generally pertinent and broadly useful to the so-called U.S. government for the long-term via increases/decreases to the Federal Funds Rate and/or increases/decreases to the loan reserve requirements of member banking organizations to directly and indirectly increase/decrease borrowing costs to public/private organizations and members of the aforementioned UNIVERSAL POPULACE™ leads to short-term appreciation/tempestuous devaluation of stock equity and/or debt bond oriented aforementioned PULIC FINANCIALS™ instruments with aforementioned fragmenting capital market inefficiencies. Further every and all purchase aforementioned PUBLIC FINANCIALS™ instruments to increase the money supply and/or sale aforementioned PUBLIC FINANCIALS™ instruments to restrict the money supply of the so-called U.S. dollar via futile, inappropriate, undeniable, unnecessary, unwarranted, illogical, unjustifiable, tempestuous exponentially detrimental and tempestuous exponentially debilitating manipulations under the guise of attempting to speculatively establish the so-called long-term monetary policy of the so-called U.S. government with day-to-day and month-by-month initiatives, schemes, ocurrences, events, endeavors, tasks and affairs, actions and proceedings, in an global marketplace which is innately in competition with the rest of the market participants and foreign currencies in the global marketplace, inevitably direclty and/or indirectly leads to feculent and feckless immediate market manipulation of currency, stock equity and bond debt instruments inclusive of, without limitation, every and all derivative techniques, designs, systems, routines, devices, manners, modes, fashions, forms, formats, factors, objects, parts, segments, elements, components, constituents, ingredients, processes, methods and combinations aforementioned PUBLIC FINANCIALS™ instruments with aforementioned fragmenting capital market inefficiencies. Thus, essentially ad knowingly under the guise of utilizing every and all legally and/or non-legally chartered devices and means available to it under the archiac Federal Reserve Act of 1913, the ancient history so-called U.S. Federal Reserve Board of Governors, ancient history so-called U.S. Federal Open Market Committee and the ancient history so-called U.S. Federal Reserve Bank attempts to arbitrarily self-manage aforementioned fragmenting capital market inefficiencies, and it is clearly an undeniable and evidentiary findings of fact, documented reference, logical scientific deduction and intuitive analytical reasoning that these arbitrary, feculent and feckless initiatives, schemes, ocurrences, happenings, interactions, processes, methods, practices, movements, proceedings, messaging, presentations, notifications, filings, submissions, records, activities, actions, events, endeavors, tasks and affairs, actions and proceedings, which may need every and all forms, part, means and segments to be censured, and thus these arbitrary, feculent and feckless initiatives, schemes, ocurrences, happenings, interactions, processes, methods, practices, movements, proceedings, messaging, presentations, notifications, filings, submissions, records, activities, actions, events, endeavors, tasks and affairs, actions and proceedings which promulgate continued and perpetual harming, damaging, inuring, insistent, insinuating, imposing, pestilent, impetuous, importune, pestiferous, condescending and insolent enthralling, hindering, entrapping, pretending, miring, fatiguing, maleficience, harassing, engulfing, pressing, malevolent, presuming, imprinting, malicious, suffocating, miring, strangling, repressing, entangling, pestering and oppressing individual members of the aforementioned UNIVERSAL POPULACE™ aforementioned PUBLIC FINANCIALS™ organizations which heretofore continuously, arrogantly, imprudently, irrationally and irresponsibly engage in propagating aforementioned fragmenting capital market inefficiencies via the communicating conduits of conceptual aids within a single holistically econometric marketplace environment. Whereas, it is an undeniable and evidentiary findings of fact, documented reference, logical scientific reasoning and intuitive analytical reasoning that every and all of the aforementioned further entail, encompass, comprise, involve, impact and/or effect propagating, promulgating and proclaiming unyielding immediate repeal of the so-called U.S. Federal Reserve Board of Governors, the so-called U.S. Federal Open Market Committee and the so-called U.S. Federal Reserve Bank's archaic legal charter, regulatory authority, scope of operations, supervisory responsibilities, transactional activites and affairs, and budgetary resources via so-called U.S. public pressure initiated by propagating, promulgating and proclaiming so-called U.S. Congressional legislation, so-called U.S. Presidential directive and so-called U.S. Surpremie Court judicial order to this effect inclusive of heightened pressure of the members of the aforementioned UNIVERSAL POPULACE™. Whereas, it is undeniably and exceptionably evident that under the guise of abitrarily establishing the long-tem money supply policy decisions in the so-called U.S., and without any form of legally vested legal charter under the Federal Reserve Act of 1913 feculently and fecklessly attempting to manage the level of so-called U.S. economic activity in relation to the level of so-called U.S. employment by utilizing in futile attempt every and all of the various hypothetical average statistical inferences which are archaic in letter, spirit, nature, scope, depth and breadth, the ancient history so-called U.S. Federal Reserve Board of Governors, ancient history so-called U.S. Federal Open Market Committee and the ancient history so-called U.S. Federal Reserve Bank is present acting as the self-appointed judge and jury, and further arbitrarily appointed self-manager, of what the prudent valuations aforementioned PUBLIC FINANCIALS™ instruments in aforementioned fragmenting capital market inefficiencies should or should not be, which is emphatically contrary to every and all prudent and risk-managed practices are comprehensively suitable, generally pertinent and broadly useful to the transactional exchange management of tens of hundreds of trillions of so-called U.S. evidentiary short-sighted day-to-day continued and perpetual harming, damaging, inuring, insistent, insinuating, imposing, pestilent, impetuous, importune, pestiferous, condescending and insolent enthralling, hindering, entrapping, pretending, miring, fatiguing, maleficience, harassing, engulfing, pressing, malevolent, presuming, imprinting, malicious, suffocating, miring, strangling, repressing, entangling, pestering and oppressing individual members of the aforementioned UNIVERSAL POPULACE™ which are traditionally concretizing via inefficient, ineffective, dysfunctional and fragmented vast networks of antiquated, archaic, ancient history and superannuated aforementioned PUBLIC FINANCIALS™ organizations which heretofore continuously, arrogantly, imprudently, irrationally and irresponsibly engage in propagating aforementioned fragmenting capital market inefficiencies via the communicating conduits of conceptual aids within a single holistically econometric marketplace environment. Whether or not so-called U.S. Federal Reserve Board of Governors, so-called U.S. Federal Open Market Committee and the so-called U.S. Federal Reserve Bank via these evidently arbitrarily imposing day-by-day, week-by-week and month-by-month adjustments, alterations and modifications in the currency of so-called U.S. dollar denominations in circulation via the world, and the under the guise of so-called long-term monetary policy decisions are illogical, unsuitable, unjustifiable, undeniable, unnecessary, unwarranted, illogical, unjustifiable, unreasoned and unmitigated, improper, conflictive and/or manipulative, and contrary to the pursuit of innovative panacean cutting-edge technological, legal, regulatory, economic, financial, accounting, and auditing solutions necessary to preemptively circumvent aforementioned PUBLIC FINANCIALS™ instruments tempestuous devaluations and mitigate increases in cost of capital with aforementioned fragmenting capital market inefficiencies. It is further an undeniable and evidentiary findings of fact, documented reference, logical scientific deduction and intuitive analytical reasoning that innovative utility engineering and architectural design propagations universal microprocessor computing design provisions should be pursued rigorously by all of mankind thorough innovative scientific and innovative developments and technological advancements which are capable of mitigating every and all tempestuous exponentially detrimental increases in systematic national sovereign borders of every and all of the industrialized, developed and developing economic commerce and trading blocs throughout the world which inevitably and logically must assume and incur the role of protecting, sustaining and expanding their respective treasure accounting, financial fueling and econometric energizing in a highly dynamic and inherently volatile, fragile, frigid and ruthless global marketplace which are logically of primary importance to ascertaining the inalienable right to life, liberty, economic prosperity, access to wealth creation and the pursuit of personal happiness within the aforementioned efficient UNIVERSAL ECONOMY™. Every and all evidentiary and inherently day-to-day continued and perpetual harming, damaging, inuring, insistent, insinuating, imposing, pestilent, impetuous, importune, pestiferous, condescending and insolent enthralling, hindering, entrapping, pretending, miring, fatiguing, maleficience, harassing, engulfing, pressing, malevolent, presuming, imprinting, malicious, suffocating, miring, strangling, repressing, entangling, pestering and oppressing individual members of the aforementioned UNIVERSAL POPULACE™ which are traditionally concretizing via inefficient, ineffective, dysfunctional and fragmented vast networks of antiquated, archaic, ancient history and superannuated aforementioned PUBLIC FINANCIALS™ organizations which heretofore continuously, arrogantly, imprudently, irrationally and irresponsibly engage in propagating aforementioned fragmenting capital market inefficiencies via the communicating conduits of conceptual aids within a single holistically econometric marketplace environment propagating and promulgate work endeavors contrary to offering the members of the aforementioned UNIVERSAL POPULACE™ the primordial and primary importance of ascertaining the inalienable right to life, liberty, economic prosperity, access to wealth creation and the pursuit of personal happiness within the aforementioned efficient UNIVERSAL ECONOMY™ via hightened levels of knowledge acquired via adamant and rigours pusuit of higher education in every and all areas comprehensively suitable, generally pertinent and broadly useful within the aforementioned efficient UNIVERSAL CAPITAL MARKET™. Whereas, it is an undeniable and evidentiary findings of fact, documented reference, logical scientific reasoning and intuitive analytical reasoning that every and all of the aforementioned Open Market Committee and the ancient history so-called U.S. Federal Reserve Bank directly and indirectly concretizes undeniable, unnecessary, undeniable, unnecessary, unwarranted, illogical, unjustifiable, unreasoned and unmitigated, illogical, unjustifiable and unreasoned exponential increases in systematic volatility and undeniable, unnecessary, unwarranted, illogical, unjustifiable, unreasoned and unmitigated increases in the cost of capital withwith aforementioned fragmenting capital market inefficiencies promulgated by the ancient history so-called U.S. Federal Reserve Board of Governors, ancient history so-called U.S. Federal Open Market Committee and the ancient history so-called U.S. Federal Reserve Bank via arbitrarily imposed changes in the money supply of so-called U.S. dollars in circulation throughout the world under the guise of so-called long-term monetary policy decisions while adamantly utilizing short-term day-to-day arbitarily bumptious and manipulative contrarian decision-making processes is illogical, unjustifiable, undeniable, unnecessary, unwarranted, illogical, unjustifiable, unreasoned and unmitigated, potentially illegal and quite frankly improper, conflictive, manipulative and potentially fatal to protecting, sustaining and expanding the treasure accounting, financial fueling and econometric energizing of the innately dynamic and inherently volatility global marketplace. It is here noted as an undeniable and evidentiary findings of fact, documented reference, and logical scientific deduction reasoning that rapid developments are underway in regulation of bank holding companies on matters related to the methods in which they price volatility via interest rates charged on commercial and retail loans offered and effectuated by bank holding companies and their subsidiary branches to members of the aforementioned UNIVERSAL POPULACE™. It is now becoming more evidently necessary and widely acknowledged that every and all techniques, designs, systems, routines, devices, manners, modes, fashions, forms, formats, factors, objects, parts, segments, elements, components, constituents, ingredients, processes, methods and combinations of present financial intermediary institutions may ineviably have to adapt to enhanced and advanced methods, proceses and procedures of disclosing interest rate risk, credit risk, default risk, and market risk are comprehensively suitable, generally pertinent and broadly useful to their respective portfolios. These present financial intermediary institutions may be required to provide every and all pricing differentials inclusive of, without limitation, every and all forms of evaluating these forms of so-called non-UNIVERSAL CAPITAL MARKET™ risks classified as applicable to members of the aforementioned UNTVERSAL POPULACE™. Although not evident to most members of the aforementioned UNIVERSAL POPULACE™ with an enormous innate and inherent stake in the outcome of the independent governing power and regulatory authority over aforementioned PUBLIC FINANCIALS™ statements inclusive of seamlessly and naturally wrapped, twisted, mixed, convoluted, embroidered and combined in connection with aforementioned PUBLIC FINANCIALS™ instruments from public/private organizations inclusive of, without limitation, aforementioned PUBLIC FINANCIALS™ instruments transactional exchange data with aforementioned PUBLIC FINANCIALS™ instruments transactional exchange information it quite an undeniable and evidentiary findings of fact, documented reference, logical scientific deduction and intuitive analytical reasoning that the ancient history so-called U.S. Federal Reserve Board of Governors, ancient history so-called U.S. Federal Open Market Committee and the ancient history so-called U.S. Federal Reserve Bank is consciously engaged in a specious, unnerving, intolerable, unacceptable, unnecessary, unwarranted and unjustifiable so-called mute battle with the so-called U.S. SEC over independent governing power and regulatory authority of every and all forms, parts, means and segement of the distinctively separate and traditionally exclusive specialty areas involving every and all public accounting, transport reconciling, independent auditing and financial reporting inclusive of without limitation, the distinctively separate and traditionally exclusive specialty areas involving every and all order-entry quotation, matching, clearance, execution, settlement and exchange aforementioned PUBLIC FINANCIALS™ instruments on every and all matters related to so-called holding companies and the archaic devices and techniques which heretofore they utilize conduct operations with aforementioned fragmenting capital market inefficiencies. It will someday soon become more understood by every and all within the members of the aforementioned UNIVERSAL POPULACE™ in comprehensive, general and broad fashion as it relates to this hereto trivial issue and hereafter mute topic that it is a clear and undeniable evidentiary findings of fact, documented reference, logical Roosevelt set forth a nationalizing legal precendent vested in the so-called U.S. Securities Act of 1933 and the so-called U.S. Securities Exchange Act of 1934 which ensures that every and all aforementioned hereto trivial and hereafter mute bureaucratic dillemas are immediately rescinded from continuation premised on the irrevocable damage to the honor, integrity of a capital market and debilitating impact and effect on the trust and confidence of the hundreds of millions of members of the aforementioned UNIVERSAL POPULACE; wherefrom invoking aforementioned UCMOST is comprehensively suitably, generally pertinent and broadly useful without a shred of doubt whatsoever of its technical, operational, administrative and managerial capacity to eradicate every and all aforementioned fragmenting market inefficiencies while simultaneously offering a swift resolution to every and all of the tremendously long-held and enormously heart-felt unmet needs in the relevant art for which the hundreds of millions of individual members of the aforementioned UNIVERSAL POPULACE are heretofore continuously subjected to unacceptable situations and intolerable capital market conditions. Most every and all of the large-scale and influential so-called holding companies which inevitably participate in the so-called U.S. banking system, and whom are inevitably members of the ancient history so-called U.S. Federal Reserve Board of Governors, ancient history so-called U.S. Federal Open Market Committee and the ancient history so-called U.S. Federal Reserve Bank are undeniably members of the aforementioned UNIVERSAL POPULACE™ participating within the aforementioned fragmenting capital market inefficiencies, thus are subject to every and all techniques, designs, systems, routines, devices, manners, modes, fashions, forms, formats, factors, objects, parts, segments, elements, components, constituents, ingredients, processes, methods and combinations of the so-called U.S. Securities Act of 1933 and the so-called U.S. Securities Exchange Act of 1934, without exception, and every and all these banking holding companies who serve the interests members of the aforementioned UNIVERSAL POPULACE™ necessarily deposit every and all techniques, designs, systems, routines, devices, manners, modes, fashions, forms, formats, factors, objects, parts, segments, elements, components, constituents, ingredients, processes, methods and combinations of currency within legal endowed escrow and deposit demand accounts belonging to members of the inefficiencies. These transactional exchanges made by bank holding companies participating in the so-called U.S. banking system mostly without the innate and inherent knowledge and present without the legally authorized authority of most members of the aforementioned UNIERSAL POPULACE™ are aforementioned PUBLIC FINANCIALS™ instruments with aforementioned fragmenting capital market inefficiencies, whether positioned in said aforementioned PUBLIC FINANCIALS™ instruments with aforementioned fragmenting capital market inefficiencies for either seconds, minutes, hours, days, weeks, months or years. These aforementioned PUBLIC FINANCIALS™ instruments are in every and all techniques, designs, systems, routines, devices, manners, modes, fashions, forms, formats, factors, objects, parts, segments, elements, components, constituents, ingredients, processes, methods and combinations, except for liquid hard currency, the exact opposite of why members of the aforementioned UNIVERSAL POPULACE™ entrust their hard-earned and taxable income wages, defined pension distributiong, deferred benefit withdrawls, individual retirement disbursements and/or government entitlements receipts in a so-called liquid, solvent and stable so-called U.S. banking sysatem. Additionally, under the guise of the trivial and unsubstantial Federal Deposit Insurance Corporation (FDIC) it is clearly an undeniable and evidentiary findings of fact, documented reference, logical scientific deduction and intuitive analytical reasoning that bank holding companies feculently and fecklessly, if not potentially under fraudulent actions, utlize false and misleading every and all real-time processing and/or reprocessing of data and/or information receiver to misguide members of the aforementioned UNIVERSAL POPULACE™ into a preconceived notion their their hard-earned and taxable income wages, defined pension distributions, deferred benefit withdrawls, individual retirement disbursements and/or government entitlements receipts in a so-called liquid, solvent and stable so-called U.R. banking sysatem is safe, when it is clearly an undeniable and evidentiary findings of fact, documented reference, logical scientific deduction and intuitive analytical reasoning that their hard-earned and taxable income wages, defined pension distributions, deferred benefit withdrawls, individual retirement disbursements and/or government entitlements receipts in a so-called liquid, solvent and stable so-called U.S. banking sysatem are components, constituents, ingredients, processes, methods and combinations of systematic volatility and increases in the cost of capital found prevalent with aforementioned fragmenting capital market inefficiencies. It is also an undeniable given evidentiary findings of fact, documented references and logical scientific deduction reasoning that the existence of the structural foundation, functional operations, transactional exchange initiatives, and therein potential importance of, or lack thereof, the ancient history so-called U.S. Federal Reserve Board of Governors, ancient history so-called U.S. Federal Open Market Committee and the ancient history so-called U.S. Federal Reserve Bank heretofore serves a debilitating and detrimental role within the so-called U.S. banking system inclusive of, without limitation, wherefrom at best it negatively energizes and fuels the heretofore inefficient, ineffective, dysfunctional and fragmented so-called U.S. banking system and international banking system, and at worst is flagrantly malicious in undertaking and employing unfair competitive practices by leveraging its structural foundation, functional operations, transactional exchange initiatives as evinced in its day-to-day promulgations of continued and perpetual harming, damaging, inuring, insistent, insinuating, imposing, pestilent, impetuous, importune, pestiferous, condescending and insolent enthralling, hindering, entrapping, pretending, miring, fatiguing, maleficience, harassing, engulfing, pressing, malevolent, presuming, imprinting, malicious, suffocating, miring, strangling, repressing, entangling, pestering and oppressing individual members of the aforementioned UNIVERSAL POPULACE™ which are traditionally concretizing via inefficient, ineffective, dysfunctional and fragmented vast networks of antiquated, archaic, ancient history and superannuated aforementioned PUBLIC FINANCIALS™ organizations; whereas, evidently and unequivocally heretofore continuously, arrogantly, imprudently, irrationally and irresponsibly engaging in propagating aforementioned fragmenting capital market inefficiencies via the communicating conduits of conceptual aids within a single holistically econometric marketplace environment. Whereas, it is an undeniable and evidentiary findings of fact, documented reference, logical scientific reasoning and intuitive analytical reasoning that every and all of the aforementioned further involve, concern and pertain to every and all techniques, designs, systems, routines, devices, holistically steady state continuous spectrum ubiquitous indistinguishably synchronous needs involving aforementioned UCMOST™ real-time processing and/or reprocessing of data and/or information content management, financial services and aforementioned PUBLIC FINANCIALS™ instruments transactional exchange initiatives, schemes, ocurrences, happenings, interactions, processes, methods, practices, movements, proceedings, messaging, presentations, notifications, filings, submissions, records, activities, actions, events, endeavors, tasks and affairs among members of the aforementioned UNIVERSAL POPULACE™, members of the aforementioned UNIVERSAL POPULACE™ which inevitably must entrust their respective livelihood and specified life, health, property, casualty, liabilities, valuables and/or factors, things, elements and/or courses of initiatives, schemes, ocurrences, happenings, interactions, processes, methods, practices, movements, proceedings, messaging, presentations, notifications, filings, submissions, records, activities, actions, events, endeavors, tasks and affairs embodying their cash liqudiity, financial solvency and economic stability at stake in the so-called U.S. banking system and W.W. banking system, so-called U.S. securities system and W.W. securities system, and so-called U.S. insurance system and W.W. insurance system and which, directly and/or indirectly, every and all are logical and evidentiary participants with aforementioned fragmenting capital market inefficiencies. It also is possible given the evidentiary findings of fact, documented reference, logical scientific deduction reasoning that the ancient history so-called U.S. Federal Reserve Board of Governors, ancient history so-called U.S. Federal Open Market Committee and the ancient history so-called U.S. Federal Reserve Bank may be, directly and/or indirectly, the quintessential root cause of the exponential increases in systematic volatility and increase in the cost of capital evinced with heretofore aforementioned fragmenting capital market inefficiencies because no matter what occurs to the valuation aforementioned PUBLIC FINANCIALS™ instruments, the ancient history so-called U.S. Federal Reserve Board of Governors, ancient history so-called U.S. Federal Open Market Committee and the ancient history so-called U.S. Federal Reserve Bank is quite ready tout, market, bolster, manipulate and/or subsidize in every and all forms, parts, means and segements its member banking holding entities and their respective branchmembers of manipulations and/or subsidies which the ancient history so-called U.S. Federal Reserve Board of Governors, ancient history so-called U.S. Federal Open Market Committee and the ancient history so-called U.S. Federal Reserve Bank promulgates and many times initiates by acting out a tyrananical role take the form of loan packages ensuring that industry, sector and country-by-country bailout losses rapidly indemnify bank holding companies, pension managers, mutual funds, endowments funds, and select high-net worth members of the aforementioned UNIVERSAL POPULACE™. This role in the so-called U.S. banking system inclusive of, without limitation, the international banking system is not the vested archaic legal charter, mission and/or purpose of the ancient history so-called U.S. Federal Reserve Board of Governors, ancient history so-called U.S. Federal Open Market Committee and the ancient history so-called U.S. Federal Reserve Bank, and is evidently displaying in every and all techniques, designs, systems, routines, devices, manners, modes, fashions, forms, formats, factors, objects, parts, segments, elements, components, constituents, ingredients, processes, methods and combinations improprieties and conflict of interest and potential fraudulent initiatives, schemes, ocurrences, happenings, interactions, processes, methods, practices, movements, proceedings, messaging, presentations, notifications, filings, submissions, records, activities, actions, events, endeavors, tasks and affairs under the guise of unwillingly needing to employ arbitrarily employed controls over the values and levels of growth involving, directly and indirectly, aforementioned PUBLIC FINANCIALS™ instruments with aforementioned fragmenting capital market inefficiencies. Clearly, the ancient history so-called U.S. Federal Reserve Board of Governors, ancient history so-called U.S. Federal Open Market Committee and the ancient history so-called U. S. Federal Reserve Bank is under the guise of arbitrarily imposing long-term monetary policy decisions on behalf of the so-called U.S. economy acts as if it were a no recourse invisible safety net, at every and all evidentiary assumed expense members of the aforementioned UNIVERSAL POPULACE™, for its member banking holding entities and their respective branchmembers of the aforementioned UNIVERSAL POPULACE™ inclusive of, without limitation, pension managers, mutual funds, endowments funds, and select high-net worth members of the aforementioned UNIVERSAL POPULACE™. The involving aforementioned UCMOST™ real-time processing and/or reprocessing of data and/or information content management, financial services and aforementioned PUBLIC FINANCIALS™ instruments transactional exchange initiatives, schemes, ocurrences, happenings, interactions, processes, methods, practices, movements, proceedings, messaging, presentations, notifications, filings, submissions, records, activities, actions, events, endeavors, tasks and affairs intermediary must plays with aforementioned fragmenting capital market inefficiencies to protect, sustain and expand the treasure accounting, financial fueling and econometric energizing of most sovereign economies of industrialized, developed and developing nations from around the world is to remain anonymous, independent and unbiased in emphatically and undeniably establishing its long-term public policy decision-making initiatives, schemes, ocurrences, happenings, interaction, processes, methods, practices, movements proceedings, messaging, presentations, notifications, filings, submissions, records, activities, actions, events, endeavors, tasks and affairs. The preconceived notion of the ancient history so-called U.S. Federal Reserve Board of Governors, ancient history so-called U.S. Federal Open Market Committee and the ancient history so-called U.S. Federal Reserve Bank that it has a vested legal charter via the Federal Reserve Act of 1913 to arbitrarily and via the utilization of the twelve federally chartered banking corporations to play out a tyrannical safety net role in a free market global marketplace economy on any scale by, directly or indirectly, attempting in a feculent and feckless manners, processes, initiatives, schemes, ocurrences, happenings, interactions, processes, methods, practices, movements, proceedings, messaging, presentations, notifications, filings, submissions, records, activities, actions, events, endeavors, tasks and affairs and actions to manage the valuation aforementioned PUBLIC FINANCIALS™ instruments with aforementioned fragmenting capital market inefficiencies via self-imposed and arbitrary manipulation of the cost of capital under the guise of establishing long-term monetary policy for the so-called U.S. banking system and international banking system is contrary to the principles of accounting, reconciling, auditing and financing where no one is less accountable than another, and moreover no one assumes more or less risk than is concretizing in a global marketplace when effectuating aforementioned PUBLIC FINANCIALS™ instruments filings, submissions, records, activities, actions, events, endeavors, tasks and affairs with aforementioned fragmenting capital market inefficiencies. The role that intermediary syndicated global bank oriented institutionalized enterprise must play in protecting, sustaining and expanding the treasure accounting, financial fueling and econometric energizing of most global economies of the industrialized, developed and developing sovereign nations of a single holistically econometric marketplace environment must at every and all costs remain anonymous, independent and unbiased in emphatically and undeniably establishing its long-term public policy decision-making initiatives, schemes, ocurrences, happenings, interactions, processes, methods, practices, movements, proceedings, messaging, presentations, notifications, filings, submissions, records, activities, actions, events, endeavors, tasks and affairs. In driving home this imminent point of view, as the so-called U.S. SEC Chairman Arthur Levitt recently reported in 1999, that such a retransformafion aforementioned fragmenting capital market inefficiencies is not a job for the so-called U.S. SEC or the so-called U.S. government because free market sovereign economies just don't work that way, hence aforementioned UCMOST™ information technology. This legal patent disclosure evincing every and all concretizing and infinitely necessary innovative developments and technologies advancements via consummate and construction reduction to practice should be construed as clear, convincing, truthful, justifiably and substantiated rubric that commercial and/or regulatory transformations are necessary within every and all multifaceted sectors and multidimensional industries entailing, encompassing, comprising, involving, impacting and/or effecting the so-called U.S. banking system and international banking system of a single holistically econometric marketplace environment, which is brought to fruition via novel, unobvious, unknown, unforeseen, unprecedented, epoch, paper-less, ease of use, fruitful, opportune, never faltering and never failing panacean cutting-edge breakthrough utility engineering and groundbreaking technological architectural design innovation driven by a single independent for-profit proprietor motivated exclusively by serving the public interest at every and all levels of business, governmental, not-for-profit and legal operations which facilitate and form the core requirements for every and all initiatives, schemes, ocurrences, happenings, endeavors, tasks and affairs transcending every and all separate and distincitve members of the aforementioned UNIVERSAL POPULACE which is undeniably, logically, scientifically and intutively inclusive of every and all multifaceted sectors and multidimensaional industries of aforementioned PUBLIC FINANCIALS organizations entailing, encompassing, comprising, involving, impacting and/or effecting every and all national sovereign industrialized, developed and developing free-market commerce and trade bloc economies within, throughout and transcending a single holistically econometric marketplace environment. The creation of this novel technological innovation is premised on actualizing optimized and efficient transport flow of holistically steady state continuous spectrum ubiquitous indistinguishably synchronous needs involving aforementioned UCMOST™ real-time processing and/or reprocessing of data and/or information content management, financial services and aforementioned PUBLIC FINANCIALS™ instruments transactional exchange initiatives, schemes, ocurrences, happenings, interactions, processes, methods, practices, movements, proceedings, messaging, presentations, notifications, filings, submissions, records, activities, actions, events, endeavors, tasks and affairs between and among members of the aforementioned UNIVERSAL POPULACE™ inclusive of, without limitation, everyone, everybody, everyhow, everyway, everything, everytime, everyplace, everywhere in the world. The quintessential panacean cutting-edge novel, unobvious, unique, unknown, unforeseen and unprecedented technological innovation invoked within aforementioned UCMOST™ information technology is furthermore comprehensively suitable, generally pertinent and broadly useful innovative formulation herewith existent innovative developments and technological advancements propagating formation of a necesssary technological framework which may pave the way toward a worldwide transition aforementioned fragmenting capital market inefficiencies via a real-time digital bridge computing platform to perpetually integrate the distinctively seperate and traditionally exclusive areas of accounting and finance capable of actualizing fill disclosure, best practices, best executions, enhanced fairness, simultaneous equality, full transparency, consolidated access and perpetual integration of individual members members of the aforementioned UNIVERSAL POPULACE™. Whereas, it is an further involve, concern and pertain to every and all techniques, designs, systems, routines, devices, manners, modes, fashions, forms, formats, factors, objects, parts, segments, elements, components, constituents, ingredients, processes, methods and combinations of factual holistically steady state continuous spectrum ubiquitous indistinguishably synchronous needs involving aforementioned UCMOST™ real-time processing and/or reprocessing of data and/or information content management, financial services and aforementioned PUBLIC FINANCIALS™ instruments transactional exchange initiatives, schemes, ocurrences, happenings, interactions, processes, methods, practices, movements, proceedings, messaging, presentations, notifications, filings, submissions, records, activities, actions, events, endeavors, tasks and affairs at the assumed expense members of the aforementioned UNIVERSAL POPULACE™, members of the aforementioned UNIVERSAL POPULACE™ which inevitably must entrust their respective livelihood and specified life, health, property, casualty, liabilities, valuables and/or factors, things, elements and/or courses of initiatives, schemes, ocurrences, happenings, interactions, processes, methods, practices, movements, proceedings, messaging, presentations, notifications, filings, submissions, records, activities, actions, events, endeavors, tasks and affairs at stake in the so-called U.S. banking system and international banking system and of which all the aforementioned, directly and/or indirectly, are logical participants with aforementioned fragmenting capital market inefficiencies it is clearly an undeniable and evidentiary findings of fact, documented reference, logical scientific deduction and intuitive analytical reasoning that major so-called U.S. banking related holding companies and their respecctive subsidiary branches have recently been identified as conduits for massive transnational money-laundering operations via special accounts from phony banks. Within an article published in the front page of the Miami Herald dated Feb. 5, 2001, it was reported that after a year-long so-called U.S. Senate Investigation of so-called correspondent banking affiliations between major so-called U.S. banks and phony offshore transnational banking havens, it became evident to this highest segement of the so-called U.S. Congress that many prominent and well-establised so-called U.S. banking related members of the aforementioned UNIVERSAL POPULACE™ are among those cited for interactions, processes, methods, practices, movements, proceedings, messaging, presentations, notifications, filings, submissions, records, activities, actions, events, endeavors, tasks and affairs via so-called correspondent banking agreements which heretofore allow banks in the so-called U.S. to provide services for banks in other countries. These so-called correspondent banking agreements between so-called U.S. banks and phony offshore foreign banks present allow so-called U.S. banks to provide banking services for foreign entities that have no physical offices and staff members which are capable of being held accountable for the transactional banking initiatives, schemes, ocurrences, happenings, interactions, processes, methods, practices, movements, proceedings, messaging, presentations, notifications, filings, submissions, records, activities, actions, events, endeavors, tasks and affairs processed via these correspondent bank accounts. Within an article published in the Miami Herald dated Mar. 3, 2001, it was reported that one of the heretofore major, extremely prominet and well-established so-called U.S. banking, securities and insurance related members of the aforementioned UNIVERSAL POPULACE™ admitted to the so-called U.S. Senate that it failed to properly monitor the accounts of two suspicious, previously scutinized and acknowledge shell oriented correspondent banks whose funds had been seized by the so-called U.S. customs service as a part of a widely publicized May 1998 drug money laundering operation pertaining to one of Mexico's well-know drug trafficking cartels and the front for the US$7.7 million money laundering scheme was a former vice minister of finance for Argentina. It is an evidentiary findings of fact, documented reference, logical scientific deduction reasoning that so-called U.S. Senator Carl Levin, a representative of Michigan, who presided over the so-called U.S. senate hearing that twenty-one months expired from the time the so-called U.S. warrant seizing the assets of the account involved in the money laundering operation was delivered before the heretofore major, extremely prominent and well-established so-called U.S. banking, securities and insurance related public organization in question closed the account in question, which enabled the fraudulent operating to transport an additional US$300 million via its New York offices. This one major, extremely prominent and well-established so-called U.S. banking, securities and insurance related public organization evidently to a breakdown in their internal communications system, adding that account managers at its offices in Argentina failed to communicate this so-called U.S. warrant seizure of the assets of the account in question to its headquarters in New York. It is an evidentiary findings of fact, documented reference, logical scientific deduction reasoning that the so-called U.S. senate believes this one major, extremely prominent and well-established so-called U.S. banking, securities and insurance related public organization engaged in troubling conduct in not immediately adhering to and complying with the so-called U.S. warrant seizing the account in question, and further engaged in disseminating misleading information comprehensively suitable, generally pertinent and broadly useful to the ownership of the account in question, wherein bank records subpoenaed by the so-called U.S. Senate Permanent Subcommittee on Investigations evinced that when this one major, extremely prominent and well-established so-called U.s. banking, securities and insurance related public organization with commercial offices in Argentina received inquiry from Argentina's Central Bank in 1999 for access to all information comprehensively suitable, generally pertinent and broadly useful to the account, the so-called U.S. banking related public organization responded that the bank records contained no information that would enbale them to determine the identity of the shareholders of the shell oriented correspondent bank account in question. In direct contrast to this 1999 action by this one major, extremely prominent and well-established so-called U.S. banking, securities and insurance related public organization, its own senior executives testified under oath to the so-called U.S. Senate that the bank did have data in its files indicating and recording ownership records of the shareholders of the shell oriented correspondent bank account which supposedly resided in the Carribbean but neither had offics nor representative personnel in the Carribbean home country. The senior executive officer of the Argentina based commercial branch offices of this one major, extremely prominent and well-established so-called U.S. banking, securities and insurance related public organization further admitted that it should have done more pertaining to providing every and all real-time processing and/or reprocessing of data and/or information receiver comprehensively suitable, generally pertinent and broadly useful to the shell oriented correspondent bank when it first received the requested inquiry from that every and all real-time processing and/or reprocessing of data and/or information receiver inclusive of, without limitation, the so-called U.S. warrant seizing the assets as part of the so-called U.S. Customs Service May 1998 of the widely publicized drug trafficking money laundering probe to its headquarters offices in New York at time of the occurence, none of which evidently occurred evincing a logical basis and justifiable reasoning for the so-called U.S. senate's concern pertaining to the engaged misleading conduct, the communication systems, supervisory oversight and account regulatory practices of this one major, extremely prominent and well-established so-called U.S. banking, securities and insurance related public organization. Ironically, an internal memorandums of this one major, extremely prominent and well-established so-called U.S. banking, securities and insurance related public organization which was made publicly available by the so-called U.S. Senate as of the date previous to this publication evinces that the anti-money laundering unit of the heretofore major, extremely prominent and well-established so-called U.S. banking related public organization did not begin depositigating the shell oriented correspondent bank's account movements from Argentina to New York until one of the anti-money laundering unit officers read an article published in the Miami Herald dated Mar. 1, 2000. The so-called U.S. Senate Investigation from the so-called U.S. Senate Permanent Subcommittee on Investigations identified that many major so-called U.S. banking related members of the aforementioned UNIVERSAL POPULACE™ in Miami, Fla. and New York City, N.Y. have established many of these correspondent banking agreement which essentially according to the so-called U.S. Senate Investigation are cloaking deposits as bank-to-bank transactions, thus avoiding the scrutiny and suspicion which are usually imposed by so-called U.S. banking regulators on small business oriented members of the aforementioned UNIVERSAL POPULACE™, members of the aforementioned UNIVERSAL POPULACET™. The so-called U.S. Senate Investigation identified that many of these correspondent banking agreement are legitimate, but there are varying cases that these forms of correspondent bank-to-bank transactional are utilized by foreign offshore banks with accounts at major so-called U.S. banking related financial institutions inclusive, without limitation, to other so-called U.S. financial institutions which may inevitably also inefficiencies. It can be gathered from the so-called U.S. Senate Investigation that South Florida, and particularly the Miami region, is identified as a target for many dubious offshore banks, because so many of these phony correspondent foreign banks are located in the Caribbean and Latin America, which preferrably choose the Southernmost region of the so-called U.S. to conduct business. Many such phony correspondent foreign offshore banks exist only on paper, or on brass plates in Caribbean and Latin America banking havens, with no building, no offices, and no employees, furthermore none are required to be subject to examination by so-called U.S. banking regulators or foreign banking regulators. This so-called U.S. Senate Investigation found that many major so-called U.S. financial institutions and predominately many prominent so-called U.S. banking related members of the aforementioned UNIVERSAL POPULACE™ opened these so-called correspondent banking agreements with many phony offshore foreign banks in an atmosphere of complacency, with lax due diligence, weak controls, and inadequate responsese to troubling information. The so-called U.S. Senate Investigation found that of the 570 banks licensed in the Cayman Islands approximately 75 or +13% percent are not branches of any other foreign banks, and some of them are mere brass plates in a lawyer office, who may themselves be fully aware of the illegal money laundering initiatives, schemes, ocurrences, happenings, interactions, processes, methods, practices, movements, proceedings, messaging, presentations, notifications, filings, submissions, records, activities, actions, events, endeavors, tasks and affairs occurring in the so-called U.S. banking system and international banking system. Furthermore, the so-called U.S. Senate Investigation found that out of approximately 400 banks licensed in the Bahamas approximately 64 or +16% percent are not affiliated with any other foreign offshore banking related members of the aforementioned UNIVERSAL POPULACE™. The so-called U.S. Senate Investigation also found that a smaller number are merely shell banks utilized to funnel dirty money into the so-called U.S. banking system, inclusive of, without limitation, the aforementioned fragmenting capital market inefficiencies. These so-called shell banks identified as foreign offshore banking related havens for laundering money within the aforementioned fragmented UNIVERSAL ECONOMY™ have no official business offices nor do they have any regularly paid staff making it nearly and questioning personnel employees, thus these foreign offshore banks are continuously effectuating money laundering via these cloaked bank-to-bank correspondent bank accounts inevitably funneling dirty money into and throughout the aforementioned fragmented UNIVERSAL ECONOMY™. In addition to so-called shell banks which utilize correspondent banking agreements to launder illicit monies into the so-called U.S. banking system and so-called U.S. capital market, the so-called U.S. Senate Investigation found that so-called U.S. banks are often used for money laundering by offshore banks that have fancy buildings and employees, but are not subject to anti-meny laundering supervisions from their countries' authorities. A June 2000 Public Audit Task Force on Money Laundering largely made up of so-called U.S. and Europen inter-governmental depositigators accentuated the troubling aspects of the aforementioned fragmented UNIVERSAL ECONOMY™ when it estimated 4,000 offshore banks in an estimated 60 countries throughout the world which are widely recognized and generally known to be financial havens precluding supervisory overight and regulatory authority from domestic and/or foreign countries. This Public Audit Task Force on Money Laundering further identified that approximately +44% of these so-called financial havens utilized to preclude taxable funds and/or launder illicit funds are located in the Caribbean and Latin America, and the Public Audit Task Force signaled out 15 countries that it described as non-cooperative with anti-money laundering efforts, inclusive of, without limitation, the Caribbean countries of the Bahamas, Cayman Islands, Dominica Republic, Panama, St. Kitts and Nevis, St. Vincent and the Grenadines, whereas the countries of Israel and Russia were also signaled out as preculding banking and financial supervisory oversight and regulatory authorities from monitoring transactional exchange initiatives, inspecting records and questioning personnel involved in these financial and banking related transactional exchange initiatives inclusive of, without limitation, being anti-money laundering efforts. The Public Audit Task Force on Money Laundering further confirmed that these countries are more likely to attract persons interested in laundering illicit proceeds that are channeled to the so-called U.S. banking system and so-called U.S. capital market via so-called shell oriented correspondent banking accounts via agreements with major prominent so-called U.S. banking and so-called international the so-called U.S. Senate depositigative report on money laundering that the so-called U.S. and Europe have recently undertaken an aggressive tactics and actions to revoke and/or suspend the licenses of some of the so-called shell oriented related correspondent banking accounts which have allegedly been involved in money laundering initiatives, schemes, ocurrences, happenings, interactions, processes, methods, practices, movements, proceedings, messaging, presentations, notifications, filings, submissions, records, activities, actions, events, endeavors, tasks and affairs to funnel illicit currency proceeds of illegal initiatives, schemes, ocurrences, happenings, interactions, processes, methods, practices, movements, proceedings, messaging, presentations, notifications, filings, submissions, records, activities, actions, events, endeavors, tasks and affairs, and so-called U.S. Senator Carl Levin who headed the so-called U.S. Senate Investigations with assistance of staff personnel subordinates believes every and all anti-money laundering operations initiatives, schemes, ocurrences, happenings, interactions, processes, methods, practices, movements, proceedings, messaging, presentations, notifications, filings, submissions, records, activities, actions, events, endeavors, tasks and affairs are a good move and reaffirmed that many more such initiatives, schemes, ocurrences, happenings, interactions, processes, methods, practices, movements, proceedings, messaging, presentations, notifications, filings, submissions, records, activities, actions, events, endeavors, tasks and affairs must be undertaken to prevent such illegal money laundering activity from entering the so-called U.S. banking system via major prominent so-called U.S. banking and financial related members of the aforementioned UNIVERSAL POPULACE™ inclusive of, without limitation, every and all of the international banking system. Furthermore, within an article published in the Miami Herald dated Feb. 23, 2001, the Organization for Economic Cooperation and Development (OECD) which is mainly comprised on the largest industrialized nations of a single holistically econometric marketplace environment have placed many Caribbean countries on a so-called black list of as many as 35 offshore juridictions which apparently tolerate tax evasions which may be causing the so-called U.S. to lose as much as US$70 billion a year in taxes routed via offshore banks that are, in reality, little more than shell corporations, and a similar OECD Financial Action Task Force has also placed many documented reference, logical scientific deduction and intuitive analytical reasoning that the so-called U.S. Senate depositigative efforts evinced that many of the so-called shell oriented correspondent banking agreements with major prominent so-called U.S. banking and financial related members of the aforementioned UNIVERSAL POPULACE™ displayed poor to non-existent administrative and anti-money laundering controls while simultaneously handling tens of millions of dollars in suspected illicit funds and compiling extensive records of dubious initiatives, schemes, ocurrences, happenings, interactions, processes, methods, practices, movements, proceedings, messaging, presentations, notifications, filings, submissions, records, activities, actions, events, endeavors, tasks and affairs associated with drug trafficking, financial fraud and other misconduct which involved aforementioned fragmented UNIVERSAL ECONOMY™. Whereas, it is an undeniable and evidentiary findings of fact, documented reference, logical scientific deduction and intuitive analytical reasoning that upwards of tens of hundreds of billions of dollars denominated in so-called U.S. or other foreign national currency secretively flow via so-called off-shore tax sheltered banking havens in the Caribbean and an article published in the front-page of the Miami Herald dated Mar. 25, 2001, reports that the so-called U.S. and its largest industrialized and developed economic trading partners throughout the world are increasingly stepping-up to enforece greater scrutiny of the approximate US$5 trillion registered off-shore because it is a widely-recognized and widely-publicized findigs of fact that these forms of currency serve as camouflage for tax evasion, fraud and massive amounts of money laundering schemes, and as quoted it is extremely likely that a significant portion of these camouflaged off-shore banking havens for tax evasion, fraud and massive amounts of money laundering schemes entailing, encompassing, comprising, involving, impacting and effecting every and all so-called medical doctors, so-called legal advocates, and and other multifaceted and multidimensional so-called professional practicioners of evidentiary fields hereto, and other so-called retired former practicioners of evidentiary fields hereto, which engage in hiding their income, assets, earnings, capital gains and access to wealth from their legitimate children of inheritance, birth-rearing spouses, marrigage spouses, estate inheritances, bankruptcy proceedings inclusive of, without heretofore veiled guise of legitimacy under of guise. Wherefrom in the case of so-called medical doctors and/or so-called medical practicioners whom arbitrarily impose and/or assess so-called necessary rates, so-called necessary fees, so-called necessary copayments and/or so-called necessary payments, while leveraging so-called back of the offer misleading, unreadable and predominately abstruse legal languages originated, effecuated, and continuously proliferating, propagating, promulgating and proclaiming every and all feculent, feckless, insolent, condescending, obnoxious, conceiting, vexing, obtrusive, obfuscating inefficient, fragmenting, intrusive, unmeritted, ineffective, menacing, pretentious, melacious, presumptuous, portentous, disparate, fruitless, unmerciful, unnecessary, unwarranted and unjustifiable exclusively for-profit exuberant, obstructing, phantom and veiled so-called insurance, assurance, health plan, health cooperative, medicare, medicare, medipass and/or medicaid unaccountable heretofore so-called claim fees, cages and expenses and/or exclusively for-profit exuberant, obstructing, phantom and veiled so-called copayments plus unaccountable hourly claim fees, charges and expenses, whence exclusively subjective business minded, driven, exploitative and profiteering heretofore so-called advocates of medicine, namely so-called heretofore interning employed medical students, heretofore employed professional medical doctors and/or heretofore so-called professional medical doctor proprietors, all of whom are feculent and feckless in disregarding ethical standards and obfuscating moral principles of a so-called professional sworn Hippocratic oath, undeniably, evidentiary, referenced, logically, scientifically and intutively thereof evinced a so-called professional sworn Hippocratic oath to which every and all persons and establishements of medical aforementioned PUBLIC FINANCIALS™ organizations within, throughout and transcending the national sovereign borders of a single holistically econometric marketplace environment shall be held, every and all of whom heretofore are, without limitation, enthralling, harrassing, oppressing, hindering, entrapping, miring, fatiguing, exposing, mischief, miser, teasing, misgiving, lynching, beheading, hanging, misguiding, defining, mishandling, misfeasance, misbelieving, misbranding, miscalling, and/or miscasting every and all of the hundreds of millions of individual members of the aforementioned UNIVERSAL POPULACE™ who can afford to clear and settle and/or cooperative, medicare, medicare, medipass and/or medicaid unaccountable heretofore so-called claim fees, charges and expenses and/or exclusively for-profit exuberant, obstructing, phantom and veiled so-called copayments plus unaccountable hourly claim fees, charges and expenses, wherefrom exclusively subjective for-profit business exploitative and profiteering initiatives, schemes, ocurrences, happenings, interactions, processes, methods, practices, movements, proceedings, messaging, presentations, notifications, filings, submissions, records, activities, actions, events, endeavors, tasks and affairs, premised on exclusively harnessing and for-profit leveraging a heretofore inefficient, ineffective, fruitless, unjust, obfuscating, untruth, obstructive, antiquated, archaic, ancient history and superannuated system of medicine, wherefrom enabling, taunting, tempting, prompting, advising, guiding, advocating and propagating these so-called aforementioned PUBLIC FINANCIALS™ organizations to unfairly reserve the right to claim and whensoever effectuate imposing upon employees, insured, beneficiaries and/or elderly enrolled individual members of the aforementioned UNIVERSAL POPULACE™ astronomically unjustifiable higher claim rates and extraordinarly unnecessary higher copayment fees inclusive of so-called insurance, assurance, health plan, health cooperative, medicare, medicare, medipass and/or medicaid, while continously touting, bolstering, purporting and misconstruing thei so-called melioristic logical positivism tactics while maliciously failing to fully disclose their assets, incomes, earnings, capital gains and access to wealth at the sole expense of hundreds of millions of individual members of the aforementioned UNIVERSAL POPULACE™. Wherefrom hereto the so-called U.S. Department of the Treasury heretofore Internal Revenue Service estimates it loses approximately US$70 billion in taxes each year because so-called U.S. citizens illegally hide their income and park their assets in off-shore banking havens, wherefrom it is an undeniable and evidetiary findings of fact, documented reference, logical scientific deduction that as far as the so-called U.S. is concerning the so-called U.S. tax codes clearly require all income earned domestically and abroad to be reported on tax returns wherefrom off-shore account holders of fraudulent so-called transnational business corporations that largest majority of whom have no legitimate business training and/or experience fradulently manipulate these tax whereas, moreover it is reported that with the onset of electronic banking mediums via the inefficient, portentous and fruitless so-called Internet, debit cards, credit cards and wire transports which enable money to flow relatively easily around the globe these illegal tax evasions, fraudulent actions and massive amounts of money laundering schemes involing medical doctors, marriage divorces, estage inheritanes, bankruptcies and organized crime syndicates are becoming increasingly prevelant among the members of the aforementioned UNIVERSAL POPULACE™ utilizing, harnessing and leveraging every and all of the aforementioned fragmenting capital market inefficiencies within a single holistically econometric marketplace environment. Whereas, it is an undeniable and evidentiary findings of fact, documented reference, logical scientific deduction and intuitive analytical reasoning that two of the heretofore major, top-tier, widely-recognized, well-capitalized and traditional commercial business, not-for-profit, asosciational, group, governmental, medial and judicial organizations formed, operated, administered and managed by the largest banking public organizations in the world, wherefrom heretofore operate the world's largest monopoly of credit card issuance and electronic transactional processing propagating, promulgating and proclaiming their evidentiary stronghold over the multifaceted industries and multidimensional sectors related to legitimate banking initiatives, schemes, ocurrences, happenings, interactions, processes, methods, practices, movements, proceedings, messaging, presentations, notifications, filings, submissions, records, activities, actions, events, endeavors, tasks and affairs, wherefrom hereto further these two of the heretofore major, top-tier, widely-recognized, well-capitalized and traditional not-for-profit organizations managed and administered by the largest banking public organizations in the world are named defendants in a bitter organized crime and racketeering lawsuit proceeding in so-called U.S. jurisdictions for contractually harming, damaging, inuring, insistent, insinuating, imposing, pestilent, impetuous, importune, pestiferous, condescending and insolent enthralling, hindering, entrapping, pretending, miring, fatiguing, maleficience, harassing, engulfing, pressing, malevolent, presuming, imprinting, malicious, suffocating, miring, strangling, repressing, entangling, pestering and oppressing heretofore inevitable and necessary members of the so-called U.S. Federal Reserve Board of Governors, so-called issuance and electronic transactional processing banking, securities and insurance related public organizations from offering their credit card issuance and transactional processing services to members of the aforementioned UNIVERSAL POPULACE™ wherefrom further hereto propagating, promulgating and proclaiming another quintessential prime example of predatory and unfair trade practices within the aforementioned fragmenting capital market inefficiencies within the aforementioned efficient UNIVERSAL ECONOMY™. It is furthermore an undeniable and evidentiary findings of fact, documented reference, logical scientific deduction and intuitive analytical reasoning that these two of the heretofore major, top-tier, widely-recognized, well-capitalized and traditional not-for-profit organizations managed and administered by the largest banking public organizations in the world, wherefrom heretofore operate the world's largest monopoly of credit card issuance and electronic transactional processing engage in comprehensively unsuitable, generally unfair and broadly impudent abating business initiatives, schemes, ocurrences, happenings, interactions, processes, methods, practices, movements, proceedings, messaging, presentations, notifications, filings, submissions, records, activities, actions, events, endeavors, tasks and affairs under the guise of so-called necessary credit line offerings to the members of the aforementioned UNIVERSAL POPULACE™ with so-called introductory low-end interest rate offerings and debt cash balance transports from other credit card issuance public organizations to force their stronghold monopoly power within the aforementioned fragmenting capital market inefficiencies within the aforementioned efficient UNIVERSAL ECONOMY™, wherefrom almost immediately upon executing any and all such comprehensively unsuitable, generally unfair and broadly impudent abating business initiatives, schemes, ocurrences, happenings, interactions, processes, methods, practices, movements, proceedings, messaging, presentations, notifications, filings, submissions, records, activities, actions, events, endeavors, tasks and affairs they exponentially spike the interest rates charged on these debt balances to undeniable, unnecessary, unwarranted, illogical, unjustifiable, unreasoned and unmitigated, undeniable, unnecessary, undeniable, unnecessary, unwarranted, illogical, unjustifiable, unreasoned and unmitigated, illogical, unjustifiable and unreasoned, unfair and unjustifiable levels inclusive of fraudulently banking tellers, and moreover imposing under guise wherefrom completely and maliciously failing to impart their charging penalties for paying off these extraordinary, exuberant and price gouging high interest rate bearing debt balances, thus comprehensively improperly entrapping the unknowning, unsophisticated, unlettered, ignorant, uneducated and unpolished members of the aforementioned UNIVERSAL POPULACE™ to a financial degree that it becomes numerically impossible given nominal wage income earnings for individual members of the aforementioned UNIVERSAL POPULACE™ to even partially liquidate their debt balances from the continuous and perpetual heretofore harming, damaging, inuring, insistent, insinuating, imposing, pestilent, impetuous, importune, pestiferous, condescending and insolent enthralling, hindering, entrapping, pretending, miring, fatiguing, maleficience, harassing, engulfing, pressing, malevolent, presuming, imprinting, malicious, suffocating, miring, strangling repressing, entangling, pestering and oppressing from the two major, top-tier, widely-recognized, well-capitalized and traditional not-for-profit organizations managed and administered by the largest banking public organizations in the world inclusive of any other such comprehensively unsuitable, generally unfair and broadly impudent abating, baiting, price gouging, entralling, engulfing and oppresive credit card and electronic transactioinal processing members of the aforementioned UNIVERSAL POPULACE™ of other credit card issuance and electronic transactional processing members of the aforementioned UNIVERSAL POPULACE™. It is an undeniable and evidentiary fidnings of fact, documented reference, logical scientific deduction and intuitive analytical reasoning that the Financial Action Task Force of the Organization for Economic Cooperation and Development in cooperation with the largest democracies in the world have taken aim at 35 jurisdictions, inclusive of 17 juridictions in the Caribbean basin, considered off-shore havens for tax evasion, fraud and massive amounts of money laundering schemes involve medical doctors and other multifaceted and multidimensional professional practicing and retired former practicioners whom engage in hiding their income and assets from their legitimate childre of inheritance and birth-rearing spouses, governing tax authorities while living under the fraudulent guise of legitimacy inclusive of marrigage divorces, estate inheritances and bankruptcies inclusive of organized crime and all of the jurisdictions are preemptively propagating herewith to clean up their acts, impose stringent anti-money laundering governing rules and regulations and facilitate full disclosure, best practices, best executions, enhanced fairness, simultaneous equality, full transparency, consolidated access and perpetual integration with those other democracies whom the members of the aforementioned UNIVERSAL POPULACE™ have engaged in illegally committing acts against the state inclusive of the following: Georgetown in the Cayman Islands considerably the largest off-shore financial ceter with approximately 600 licensed banks and trust companies, 2,238 mutual fund transactional exchange companies, 499 captive insurance companies and more than 40,000 off-shore companies registered within the jurisdiction who little of no actual places of operations within the Cayman Islands; Nassaua in the Bahamas with more than 400 banks and trust companies with assets exceeding US$260 billion, more than 600 mutual fund transactional exchange companies and 600 standard and risk financing captive insurance companies inclusive of approximately 100,000 so-called fraudulent guised transnational business corporations registered within its jurisdictions predominately from non-residents of the Bahamas; St. John's in Antigua and Barbuda with approximately 11 commercial banks, 50 off-shore banks and deposits exceeding US$544 million as of August 1999; wherefrom hereto unfair tax havens inclusive of, without limitation, all of the following: Andorra, Anguilla, Antigua and Barbuda, Aruba, Bahrain, Barbados, Belize, Cook Islands, Dominica, Gibraltar, Guemsey/Sark/Alderney, Grenada, Isle of Man, Israel, Jersey, Lebanon, Liberia, Liechtenstein, Maldives, Marshall Islands, Monaco, Montserrat, Nauru, Niue, Netherlands Antilles, Panama, Philippines, Russia, Samoa, Seychelles, St. Kitts aned Nevis, St. Lucia, St. Vincent and the Grenadines, Tonga, Turks and Caicos; so-called U.S. Virgit islands; British Virglt islands; Vanuatu; wherefrom hereto only the Cayman Islands is not an aforementioned unfair tax haven via the Financial Action Task Force of the Organization of Economic Cooperation and Development via the article published in the front-page of the Miami Herald dated Mar. 25, 2001. It is also an undeniable and evidentiary findings of fact, documented reference, logical scientific deduction and intuitive analytical reasoning that many other fraudulent banking related schemes involve domestic and/or foreign initiatives, schemes, ocurrences, happenings, endeavors, tasks and affairs which extend to issuing false and misleading incoherent advertisements to members of the aforementioned UNIVERSAL POPULACE™ and furthermore involve shipping charges and real-time automatizing credit card billing initiatives, schemes, ocurrences, happenings, interactions, processes, methods, practices, movements, proceedings, messaging, presentations, notifications, filings, submissions, records, activities, actions, events, endeavors, tasks and affairs. Within an article published in the business section of the Miami Herald dated Jan. 12, 2001, it was reported that the State of Florida's Attorney General's Office has filed a lawsuit accusing several buying clubs of billing consumers credit cards real-time automatizingally for membership subscriptions they did not authorize or requisition. The named defendant to the lawsuit filed in Broward County Circuit Court as a direct violation of the State of Florida's Deceptive and Unfair Trade Practices Act were located in Boca Raton and the five organizations which participated in this fraudulent scheme were managed by two men whom apparently bilked members of the aforementioned UNIVERSAL POPULACE™ out of US$300 million dollars for one-year membership subscriptions after the clubs were awarded free 30-day memberships, but did not tell them that each would be billed for a one-year membership if they personally did not cancel by the end of 30 days. Furthermore, a joint venture between two of the named defendants to the lawsuit filed by the State of Florida's Attorney General's Office involved the advertisement of so-called free products, and subsequently members of the aforementioned UNIVERSAL POPULACE™ were charged exuberant shipping charges and delivered a so-called special bonus 30-day trial club membership into the fraudulent scheme of the named defendants. Therefore, it is clearly an undeniable and evidentiary findings of fact, documented reference, logical scientific deduction and intuitive analytical reasoning that there does exist a long-held heart-felt need in the relevant art for innovative and technologically panacean cutting-edge innovative developments and technological advancements which promulgate utility engineering and architectural design propagations universal microprocessor computing design provisions to meet the unmet holistically steady state continuous spectrum ubiquitous indistinguishably synchronous needs involving aforementioned UCMOST™ real-time processing and/or initiatives, schemes, ocurrences, happenings, interactions, processes, methods, practices, movements, proceedings, messaging, presentations, notifications, filings, submissions, records, activities, actions, events, endeavors, tasks and affairs of legitimate members of the aforementioned UNIVERSAL POPULACE™ whose treasure accounting, financial fueling and econometric energizing is subjected to undeniable, unnecessary, unwarranted, illogical, unjustifiable, unreasoned and unmitigated increasing systematic volatility and unjustifiable increases in the cost of capital within the aforementioned fragmenting capital market inefficiencies within the aforementioned efficient UNIVERSAL ECONOMY™ because of the prevelant continued and perpetual harming, damaging, inuring, insistent, insinuating, imposing, pestilent, impetuous, importune, pestiferous, condescending and insolent enthralling, hindering, entrapping, pretending, miring, fatiguing, maleficience, harassing, engulfing, pressing, malevolent, presuming, imprinting, malicious, suffocating, miring, strangling, repressing, entangling, pestering and oppressing individual members of the aforementioned UNIVERSAL POPULACE™ which are traditionally concretizing via inefficient, ineffective, dysfunctional and fragmented vast networks of antiquated, archaic, ancient history and superannuated aforementioned PUBLIC FINANCIALS™ organizations which heretofore continuously, arrogantly, imprudently, irrationally and irresponsibly engage in propagating aforementioned fragmenting capital market inefficiencies via the communicating conduits of conceptual aids within a single holistically econometric marketplace environment. Whereas, it is an undeniable and evidentiary findings of fact, documented reference, logical scientific reasoning and intuitive analytical reasoning Whereas, it is an undeniable and evidentiary findings of fact, documented reference, logical scientific deduction and intuitive analytical reasoning that the novel, unobvious, unique, unknown, unforeseen, unprecedented, ease of use and panacean cutting-edge technological innovations invoked within aforementioned UCMOST™ information technology is moreover comprehensively suitable, generally pertinent and broadly useful utility and design formulation herewith existent and furthermore fully capable of formulating establishment of a novel, unobvious, unique, unknown, unforeseen and unprecedented holistically steady state continuous spectrum ubiquitous indistinguishably synchronous PUBLIC FINANCIALS™ instruments transactional exchange driven UNIVERSAL CAPITAL MARKET™ in a necessarily integrated and increasingly integrated UNIVERSAL ECONOMY™ wherefrom serving the unmet needs in the relevant art in an anonymous, independent, impartial and perpetual fashion serves the best interests of every and all members of the aforementioned UNIVERSAL POPULACE™. It is here noted that there exists a major inefficiency in the transnational financial system on matter related to bank holding companies and the manner in which these specificmembers of the aforementioned UNIVERSAL POPULACE™ generate earnings from transactional exchange instruments not necessarily considered, interest-bearing loan oriented, check-clearing and wire tranfer services. Evidently, banking holding oriented members of the aforementioned UNIVERSAL POPULACE™ which re supposed entrusted with the functions of serve the aforementioned efficient UNIVERSAL ECONOMY™ as independent accounting intermediaries that facilitate transport of economic currency oriented transactional exchange initiatives inevitably are directly and indirectly involved in utilizing the escrow and demand deposit currency members of the aforementioned UNIVERSAL POPULACE™ to seamlessly and naturally transactional exchange initiatives, schemes, ocurrences, happenings, interactions, processes, methods, practices, movements, proceedings, messaging, presentations, notifications, filings, submissions, records, activities, actions, events, endeavors, tasks and affairs involving aforementioned PUBLIC FINANCIALS™ instruments for their own profit-oriented benefits and thereby inappropriate leverage their enthrallment over members of the aforementioned UNIVERSAL POPULACE™ to inappropriately and without justifiable substantive logic or reasoning requisite members of the aforementioned UNIVERSAL POPULACE™ to assume exuberant effectuating transactional exchange initiatives, schemes, ocurrences, happenings, interactions, processes, methods, practices, movements, proceedings, messaging, presentations, notifications, filings, submissions, records, activities, actions, events, endeavors, tasks and affairs involving, without limitation, escrow and demand deposit check-clearing and wire transport oriented services, public captial market securities PUBLIC FINANCIALS™ instruments, and related financial vehicles, that entail insurance policies and contracts, commercial loans, residential loans, commercial assessments, charges, fees, tariffs, sur-charges under the unjustifiable guise of credit risk, default risk, interest rate risk, currency risk, business risk, financial risk, and assuming other forms of managed risk within the aforementioned efficient UNIVERSAL ECONOMY™. When further analyzing the escrow and demand deposit intermediary accounting functions and currency transactional exchange initiatives, schemes, ocurrences, happenings, interactions, processes, methods, practices, movements, proceedings, messaging, presentations, notifications, filings, submissions, records, activities, actions, events, endeavors, tasks and affairs which banking related members of the aforementioned UNIVERSAL POPULACE™ and their subsidiary branches undertake in the so-called U.S. economy is becomes an undeniable and evidentiary finding of fact, documented reference, logical scientific deduction and intuitive analytical reasoning that these members of the aforementioned UNIVERSAL POPULACE™ are simply an extension aforementioned fragmenting capital market inefficiencies. For example, in analyzing the general operating characteristics, general functions and negotiated dealings of one of the largest multinational banks in the world as recently reported in a highly respected and specialty financial publication referenced as Forbes magazine referenced in some detail the banking oriented public organization's operating divisions are general units and facilitates thus evincing a clear, yet very broad understanding of the role of the functions and transactional oriented operations regarding the divisions of a multinational bank holding company. The operations, instruments, and intermediary dealings of these multinational banking oriented members of the aforementioned UNIVERSAL POPULACE™ take the form of global financial service organizations that offers members of the aforementioned UNIVERSAL POPULACE™ any number of derivative forms syndicated loans to facilitate mergers, acquisitions, business combinations, and assist in financial distress calls from legitimate organizations, inclusive of, without limitation, offering escrow and demand deposit check-clearing and wire transport oriented services, public captial market securities PUBLIC FINANCIALS™ instruments, and related financial vehicles, that entail insurance policies and contracts, commercial loans, residential loans, commercial lines of credit, residential lines of credit, credit cards, debt cards, and further inappropriately charge extraordinary, miniscule as to be considered trivial and non-existent on an after-tax basis, inclusive of other forms of assessments, charges, fees, tariffs, sur-charges under the guise of credit risk, default risk, interest rate risk, currency risk, business risk, financial risk, and assuming other forms of managed risk which are part and form of the aforementioned fragmenting capital market inefficiencies. It is an evidentiary findings of fact, documented reference, logical scientific deduction and intuitive analytical reasoning thatbanking related public organizaitons present offer members of the aforementioned UNIVERSAL POPULACE™ a wide-range aforementioned PUBLIC FINANCIALS™ instruments transactional exchange initiatives, schemes, ocurrences, happenings, interactions, processes, methods, practices, movements, proceedings, messaging, presentations, notifications, filings, submissions, records, activities, actions, events, endeavors, tasks and affairs, that include, without limitations, taking position in foreign currencies, taking positions in treasuries, working commercial paper, and negotiating high-yield corporate notes and bonds, along with over-the-counter derivative oriented PUBLIC FINANCIALS™ instruments, and customized aforementioned PUBLIC FINANCIALS™ instruments that dominate over-the-counter and bulletin-board markets. It is clearly an undeniable and evidentiary findings of fact, documented reference, logical scientific deduction and intuitive analytical reasoning that banking oriented members of the aforementioned UNIVERSAL POPULACE™ and their subsidiary branches are not limited to earning interest on commercial and residential mortgages, automobile loans, commercial enterprise loans under the guise of credit risk, default risk, interest rate risk, currency risk, business risk, financial risk, and assuming other forms of managed risk within the aforementioned efficient UNIVERSAL ECONOMY™, but rather earn income from escrow and demand deposit currency oriented savings accounts, and wire transport and check draft clearing services inclusive of, without limitation, assuming every and all techniques, designs, systems, routines, devices, manners, modes, fashions, forms, formats, factors, objects, parts, segments, elements, components, constituents, ingredients, processes, methods and combinations of appreciative capital gains and interest income directly effectuating transactions inaforementioned PUBLIC FINANCIALS™ instruments and indirectly from inappropriately charging exuberant aforementioned PUBLIC FINANCIALS™ instruments transactional exchange initiatives, schemes, ocurrences, happenings, interactions, processes, methods, practices, movements, proceedings, messaging, presentations, notifications, filings, submissions, records, activities, actions, events, endeavors, tasks and affairs with aforementioned fragmenting capital market inefficiencies. These bank holding companies and their subsidiary branches which are in their largest techniques, designs, systems, routines, devices, manners, modes, fashions, forms, formats, factors, objects, parts, segments, elements, components, constituents, ingredients, processes, methods and combinations staffed by sales commissioned account executives are essentially accounting and finance drivenmembers of the aforementioned UNIVERSAL POPULACE™ which assume, distribute and syndicate differeing techniques, designs, systems, routines, devices, manners, modes, fashions, forms, formats, factors, objects, parts, segments, elements, components, constituents, ingredients, processes, methods and combinations of risk assumption and transport oriented services from members of the aforementioned UNIVERSAL POPULACE™ within the aforementioned efficient UNIVERSAL ECONOMY™, who are inevitably logical direct and indirect participants with aforementioned fragmenting capital market inefficiencies, and therewithal charge excessively for escrow and demand deposit currency savings accounts, wire tranfer and check draft clearing services, inclusive of transactional exchange advisory, asset management and aforementioned PUBLIC FINANCIALS™ instruments transactional exchange services which logically evinces that these banking oriented members of the aforementioned UNIVERSAL POPULACE™ and their subsidiary branches are in every and all techniques, designs, systems, routines, devices, manners, modes, fashions, forms, formats, factors, objects, parts, segments, elements, components, constituents, ingredients, processes, methods and combinations not unlike or in every and all techniques, designs, systems, routines, devices, manners, modes, fashions, forms, formats, factors, objects, parts, segments, elements, components, constituents, ingredients, processes, methods and combinations different in letter, spirit, nature, scope, breadth and depth from counterpart securities and insurance related members of the aforementioned UNIVERSAL POPULACE™ and their subsidiary branches inclusive of POPULACE™, inclusive of, without limitation, their subsidiary branches and sales commissioned account executives are completely involved in, without limitation, aforementioned PUBLIC FINANCIALS™ instruments transactional exchange initiatives, schemes, ocurrences, happenings, interactions, processes, methods, practices, movements, proceedings, messaging, presentations, notifications, filings, submissions, records, activities, actions, events, endeavors, tasks and affairs, which further include offering members of the aforementioned UNIVERSAL POPULACE™ every and all techniques, designs, systems, routines, devices, manners, modes, fashions, forms, formats, factors, objects, parts, segments, elements, components, constituents, ingredients, processes, methods and combinations of discretionary asset management services, commercial and residential mortgage obligations, commercial and consumer oriented lines of credit, moving vehicle loans, escrow and demand deposit currency savings accounts, and other aforementioned PUBLIC FINANCIALS™ instruments transactional exchange services involving, without limitaiton, offering respectivley mutual funds, life and health insurance policies, fixed and variable annuity contracts, and other techniques, designs, systems, routines, devices, manners, modes, fashions, forms, formats, factors, objects, parts, segments, elements, components, constituents, ingredients, processes, methods and combinations of financial oriented planning and tax payment related services. Whereas, it is an undeniable and evidentiary findings of fact, documented reference, logical scientific deduction and intuitive analytical reasoning that banking related members of the aforementioned UNIVERSAL POPULACE™ and their subsidiary branches inclusive of, without limitation, their sales commissioned staff personnel employees may need to succumb to the new and higher standards of full disclosure, best practices, best executions, enhanced fairness, simultaneous equality, full transparency, consolidated access and perpetual integration of members members of the aforementioned UNIVERSAL POPULACE™ involving the monitoring of currency levels held at each so-called U.S. banking system related firm and offer full transparency of the varying tier pricing plans which justify their charging different levels of interest rates and service charges to members of the aforementioned UNIVERSAL POPULACE™ for effectuating escrow and demand deposit account wire transport and analytical reasoning that banking related members of the aforementioned UNIVERSAL POPULACE™ and their subsidiary branches utilize various techniques, designs, systems, routines, devices, manners, modes, fashions, forms, formats, factors, objects, parts, segments, elements, components, constituents, ingredients, processes, methods and combinations of currency and credit available in escrow and demand deposit accounts from members of the aforementioned UNIVERSAL POPULACE™ to seamlessly and naturally and profit from the differential of trivial interest earned from these escrow and demand deposit accounts and the capital gains and interests income from their transactional exchange initiatives, schemes, ocurrences, happenings, interactions, processes, methods, practices, movements, proceedings, messaging, presentations, notifications, filings, submissions, records, activities, actions, events, endeavors, tasks and affairs inaforementioned PUBLIC FINANCIALS™ instruments with aforementioned fragmenting capital market inefficiencies. It is an evidentiary fidnings of fact, documented reference, logical scientific deduction reasoning that banking related members of the aforementioned UNIVERSAL POPULACE™ and their subisidiary branches offer these escrow and demand deposit accounts at levels of interest earned by members of the aforementioned UNIVERSAL POPULACE™ which are ludicrous in comparison to the capital gains and interests income earned by the banking related members of the aforementioned UNIVERSAL POPULACE™ for consolidating the day-to-day excess surplus of currency and credit available in their members of the aforementioned UNIVERSAL POPULACE™ escrow and demand deposit accounts. For example, in the business section of the Miami Herald dated Mar. 1, 2001, it is quoted that the average money market escrow and/or demand deposit account in a typical South Florida banking related public organization is +2.24%, while similarly the three month so-called U.S. Treasury bill and six month so-called U.S. Treasury bills average +4.71% and +4.49% respectively. Furthermore, the lowest rate charged to members of the aforementioned UNIVERSAL POPULACE™ is the so-called prime rate of interest charged on every and all borrowing of loans and/or lines of credit offered to public oganizations and members of the aforementioned UNIVERSAL POPULACE™ prior to factoring in an exuberant add-on increase in the interest rate which together form the subsidiary branches are at their own discretion with little or no supervisory oversight, governing rules and authoritative regulations which would requisite their justifying the logical basis and substantive reasoning for imposing every and all surcharge interest rates beyond the prime rate of interest to members of the aforementioned UNIVERSAL POPULACE™ with less access to wealth and/or established borrowing history than those members of the aforementioned UNIVERSAL POPULACE™ who display access to wealth and/or establishd borrowing history. Moreover, these banking related members of the aforementioned UNIVERSAL POPULACE™ and the subsidiaries falsely mislead members of the aforementioned UNIVERSAL POPULACE™ into preconceived notions they actually must be charged exuberant rates of interest on borrowing currency and/or lines of credit above the prime rate of interest when seeking loans and/or lines of credit because of the increased risk associated with their lack of access to wealth and/or established borrowing history when it is clearly an undeniable and evidentiary findings of fact, documented reference, logical scientific deduction and intuitive analytical reasoning that every and all available currency and credit available in the escrow and demand deposit accounts members of the aforementioned UNIVERSAL POPULACE™ are consolidated by the member so-called U.S. banking system firm and utilized to capitalize on appreciative capital gains and interest income from the purchase and sale aforementioned PUBLIC FINANCIALS™ instruments with aforementioned fragmenting capital market inefficiencies. Furthermore, it is also an undeniable and evidentiary findings of fact, documented reference, logical scientific deduction and intuitive analytical reasoning that banking related members of the aforementioned UNIVERSAL POPULACE™ and their subsidiary branches deceive and falsely mislead members of the aforementioned UNIVERSAL POPULACE™ under the guise of the so-called Federal Deposit Insurance Corporation (FDIC) which supposedly insures escrow and demand deposit accounts up to an limited amount of US$100,000 if the specific banking related public organization where ownership of the currency and credit by members of the aforementioned UNIVERSAL POPULACE™ is held happens to enter into bankruptcy. First of all, it is clearly an undeniable and evidentiary findings of fact, documented reference, logical scientific deduction and intuitive analytical reasoning as herein aforementioned UNIVERSAL POPULACE™ have less than US$10,000 in currency, credit or other forms of assets which can be readily converted to currency to cover every and all emergencies which may from time to time arise in their day-to-day lives. Secondly, given the bailout of savings and loans banking related members of the aforementioned UNIVERSAL POPULACE™ and their subsidiaries in the latter part of the 1980's inclusive of without limitation, that so-called U.S. Federal Reserve Board of Governors, Federal Open Market Committee, and so-called U.S. Federal Reserve Banks inefficient, ineffective, dysfunctional and fragmented existence in the so-called U.S. banking system, it is clearly an undeniable and evidentiary findings of fact, documented reference, logical scientific deduction and intuitive analytical reasoning that banking related members of the aforementioned UNIVERSAL POPULACE™ and their subsidiary branches do not enter into bankruptcy in the so-called U.S. economy because if they are hereto discovered to be illiquid, insolvent and unstable the assets, liabilities and equities are acquired by a more liquid, solvent and stable banking related public organization wherewithin the aforementioned illiquid, insolvent and unstable banking related firm simply becomes one of any number of subsidiary branches of the more liquid, solvent and stable banking related public organization, and this is clearly evinced by the massive banking related public organization consolidations which took place in the latter part of the 1990's. Therefore, when banking related members of the aforementioned UNIVERSAL POPULACE™ and the subsidiary branches utilize the preconceived notion of the Federal Deposit Insurance Corporation (FDIC) as a safety net guarantee that the currency and credit in the escrow and demand deposit accounts members of the aforementioned UNIVERSAL POPULACE™ is safe and protected from the tempestuous exponentially debilitating increases in systematic volatility and tempestuous exponentially detrimental increases in the cost of capital assumed in consolidated form by the banking related public organization inclusive of, without limitation, its subsidiary branches by leveraging the currency and credit available members of the aforementioned UNIVERSAL POPULACE™ to seamlessly and naturally for-profit related transactional exchange initiatives, schemes, ocurrences, happenings, interactions, processes, methods, practices, movements, proceedings, volatile aforementioned PUBLIC FINANCIALS™ instruments with aforementioned fragmenting capital market inefficiencies is deceitful, false and misleading, and potentially evinces the appearance of improprieties involving advertisement, merchandising, unfair trade practices, conspiracy and mail fraud on the part of banking related members of the aforementioned UNIVERSAL POPULACE™ who utilize every and all techniques, designs, systems, routines, devices, manners, modes, fashions, forms, formats, factors, objects, parts, segments, elements, components, constituents, ingredients, processes, methods and combinations available to them in the global marketplace to gather assets in the forms of currency and credit inclusive, at times, aforementioned PUBLIC FINANCIALS™ instruments which can be borrowed against to seamlessly and naturally further transactional exchange initiatives, schemes, ocurrences, happenings, interactions, processes, methods, practices, movements, proceedings, messaging, presentations, notifications, filings, submissions, records, activities, actions, events, endeavors, tasks and affairs with aforementioned fragmenting capital market inefficiencies. Whereas, it is an undeniable and evidentiary findings of fact, documented reference, logical scientific deduction and intuitive analytical reasoning that no banking related public organization and its subisidiary branches which is a legally state, federal or foreign chartered member of the so-called U.S. banking system should be allowed to deceitfully and falsely mislead members of the aforementioned UNIVERSAL POPULACE™ into either transportring their assets and/or borrowing currency and/or credit lines because at the typical wage income earning salary in addition to the exuberant rates of interests charged by banking related public organization and their subisidiaries every and all techniques, designs, systems, routines, devices, manners, modes, fashions, forms, formats, factors, objects, parts, segments, elements, components, constituents, ingredients, processes, methods and combinations of debt can increase exponentially and prohibit the unsophisticated members of the aforementioned UNIVERSAL POPULACE™ from ever finding themselves in a position of being relieved of debt and in pursuit of access to wealth, prosperity and protection, sustenance and expansion of their treasure accounting, financial fueling and econometric energizing. Ironically, these banking related members of the aforementioned UNIVERSAL POPULACE™ and their service related accounts to earn exuberant transactional exchange fees and charges, and sales commissions, operating marketing and advertisment fees and surcharge and discretionary asset management fees and charges for effectuating aforementioned PUBLIC FINANCIALS™ instruments transactional exchange initiatives, schemes, ocurrences, happenings, interactions, processes, methods, practices, movements, proceedings, messaging, presentations, notifications, filings, submissions, records, activities, actions, events, endeavors, tasks and affairs as intermediaries which heretofore enthrall members of the aforementioned UNIVERSAL POPULACE™ from prudently striving for, attaining and/or acquiring access to wealth, treasure accounting, financial fueling and econometric energizing in a highly dynamic and inherently volatile so-called U.S. economy which is intrinsically driven and functions in today's economy based on consumer purchase of products, goods, supplies and services and information technology, rather than its historical industrial, manufacturing and agricultural economic subsistence. Whereas, it is an undeniable and evidentiary findings of fact, documented reference, logical scientific deduction and intuitive analytical reasoning that significant inefficiencies in the heretofore inefficient, ineffective, dysfunctional and fragmented so-called U.S. banking system, which inevitably involves every and all banking related members of the aforementioned UNIVERSAL POPULACE™ and their subsidiary branches inevitably lead to fraud and manipulation in every and all basic elemental developments, necessary interactions and integral transactional initiatives, schemes, ocurrences, happenings, interactions, movements, activities, events, endeavors, practices, tasks and affairs which directly and/or indirectly involve the distinctively separate and traditionally exclusive specialty areas of the efficient, effective, functional and integrated streamlined, alternating scale, inseparable, seamless and natural wrapping, interlacing, coiling, coupling, combining and interlocking techniques, designs, systems, routines, devices, manners, modes, fashions, forms, formats, factors, objects, parts, segments, elements, components, constituents, ingredients, processes, methods and organizational combinations. For example, in a U.S. SEC case brought against a prominent and well-established banking related public organization operating in the Southeastern region of the so-called U.S. it became apparent that this banking related public organization opened the door to acknowledgement of wide-spread abuse of earnings manipulation inmembers of the aforementioned UNIVERSAL POPULACE™ inclusive of every and all banking related members of the aforementioned UNIVERSAL POPULACE™, but not in limitation of every and all other industries and sectors of the so-called U.S. economy and W.W. Economy. In two other examples, it is alleged that two prominent and well-established national banking related members of the aforementioned UNIVERSAL POPULACE™ which are actively involved in securities transactional and securities clearing and settlement enterprise initiatives, schemes, ocurrences, happenings, interactions, processes, methods, practices, movements, proceedings, messaging, presentations, notifications, filings, submissions, records, activities, actions, events, endeavors, tasks and affairs involving aforementioned fragmenting capital market inefficiencies inclusive of, without limitation, their subsidiary branches and predominately sales commissioned account representatives had illegally mismanaged funds and assisted foreigners in money laundering and organized white-collar crime initiatives, schemes, ocurrences, happenings, interactions, processes, methods, practices, movements, proceedings, messaging, presentations, notifications, filings, submissions, records, activities, actions, events, endeavors, tasks and affairs involving the so-called U.S. banking system. The so-called U.S. SEC Investigation of the regionally operating banking related public organization prompted unprecedented regulatory initiatives, schemes, ocurrences, happenings, interactions, processes, methods, practices, movements, proceedings, messaging, presentations, notifications, filings, submissions, records, activities, actions, events, endeavors, tasks and affairs beyond the banking industry to include specifically, but not in limitation of, the so-called U.S. SEC and insurance industries, and inevitably prompted a furious battle between the so-called U.S. SEC and the ancient history so-called U.S. Federal Reserve Board of Governors, ancient history so-called U.S. Federal Open Market Committee and the ancient history so-called U.S. Federal Reserve Bank given the banking industries involvement in illegally managing asset reserves and manipulative financial reporting of earnings, and this inevitable regulatory power struggle entail, encompass, comprise, involve, impact and/or effect every and all techniques, designs, systems, processes, parts, segments, methods loans outstanding in their transactional exchange portfolios to members of the aforementioned UNIVERSAL POPULACE™. Whereas, it is an undeniable and evidentiary findings of fact, documented reference, logical scientific deduction and intuitive analytical reasoning that two of the heretofore major, top-tier, widely-recognized, well-capitalized and traditional not-for-profit organizations managed and administered by the largest banking public organizations in the world, wherefrom heretofore operate the world's largest monopoly of credit card issuance and electronic transactional processing propagating, promulgating and proclaiming their evidentiary stronghold over the multifaceted industries and multidimensional sectors related to legitimate banking initiatives, schemes, ocurrences, happenings, interactions, processes, methods, practices, movements, proceedings, messaging, presentations, notifications, filings, submissions, records, activities, actions, events, endeavors, tasks and affairs, wherefrom hereto further these two of the heretofore major, top-tier, widely-recognized, well-capitalized and traditional not-for-profit organizations managed and administered by the largest banking public organizations in the world are named defendants in a bitter organized crime and racketeering lawsuit proceeding in so-called U.S. jurisdictions for contractually harming, damaging, inuring, insistent, insinuating, imposing, pestilent, impetuous, importune, pestiferous, condescending and insolent enthralling, hindering, entrapping, pretending, miring, fatiguing, maleficience, harassing, engulfing, pressing, malevolent, presuming, imprinting, malicious, suffocating, miring, strangling, repressing, entangling, pestering and oppressing heretofore inevitable and necessary members of the so-called U.S. Federal Reserve Board of Governors, so-called U.S. Federal Open Market Committee and so-called U.S. Federal Reserve Bank into precluding and preventing other legitimate and competitively positioned credit credit card issuance and electronic transactional processing banking, securities and insurance related public organizations from offering their credit card issuance and transactional processing services to members of the aforementioned UNIVERSAL POPULACE™ wherefrom further hereto propagating, promulgating and proclaiming another quintessential prime example of predatory and unfair trade practices within the aforementioned fragmenting capital market inefficiencies within the aforementioned efficient UNIVERSAL ECONOMY™. heretofore major, top-tier, widely-recognized, well-capitalized and traditional not-for-profit organizations managed and administered by the largest banking public organizations in the world, wherefrom heretofore operate the world's largest monopoly of credit card issuance and electronic transactional processing engage in comprehensively unsuitable, generally unfair and broadly impudent abating business initiatives, schemes, ocurrences, happenings, interactions, processes, methods, practices, movements, proceedings, messaging, presentations, notifications, filings, submissions, records, activities, actions, events, endeavors, tasks and affairs under the guise of so-called necessary credit line offerings to the members of the aforementioned UNIVERSAL POPULACE™ with so-called introductory low-end interest rate offerings and debt cash balance transports from other credit card issuance public organizations to force their stronghold monopoly power within the aforementioned fragmenting capital market inefficiencies within the aforementioned efficient UNIVERSAL ECONOMY™, wherefrom almost immediately upon executing any and all such comprehensively unsuitable, generally unfair and broadly impudent abating business initiatives, schemes, ocurrences, happenings, interactions, processes, methods, practices, movements, proceedings, messaging, presentations, notifications, filings, submissions, records, activities, actions, events, endeavors, tasks and affairs they exponentially spike the interest rates charged on these debt balances to undeniable, unnecessary, unwarranted, illogical, unjustifiable, unreasoned and unmitigated, undeniable, unnecessary, undeniable, unnecessary, unwarranted, illogical, unjustifiable, unreasoned and unmitigated, illogical, unjustifiable and unreasoned, unfair and unjustifiable levels inclusive of fraudulently failing to impart excessive charges, fees and surcharges on these debt balances or the accessing of available cash balances via automated teller machines and/or physical banking tellers, ad moreover imposing under guise wherefrom completely and maliciously failing to impart their charging penalties for paying off these extraordinary, exuberant and price gouging high interest rate bearing debt balances, thus comprehensively improperly entrapping the unknowning, unsophisticated, unlettered, ignorant, uneducated and unpolished members of the aforementioned UNIVERSAL POPULACE™ to a financial degree that it becomes numerically impossible given continuous and perpetual heretofore harming, damaging, inuring, insistent, insinuating, imposing, pestilent, impetuous, importune, pestiferous, condescending and insolent enthralling, hindering, entrapping, pretending, miring, fatiguing, maleficience, harassing, engulfing, pressing, malevolent, presuming, imprinting, malicious, suffocating, miring, strangling, repressing, entangling, pestering and oppressing from the two major, top-tier, widely-recognized, well-capitalized and traditional not-for-profit organizations managed and administered by the largest banking public organizations in the world inclusive of any other such comprehensively unsuitable, generally unfair and broadly impudent abating, baiting, price gouging, entralling, engulfing and oppresive credit card and electronic transactioinal processing members of the aforementioned UNIVERSAL POPULACE™ of other credit card issuance and electronic transactional processing members of the aforementioned UNIVERSAL POPULACE™. Furthermore, in an example of the extension of this evidentiary regulatory power struggle between the so-called U.S. SEC and the ancient history so-called U.S. Federal Reserve Board of Governors, ancient history so-called U.S. Federal Open Market Committee and the ancient history so-called U.S. Federal Reserve Bank, a well regarded derivative oriented and discretionary hedge mutual fund lost billions of so-called U.S. dollars in 1998 by utilizing complex theoretical based and speculative quantitative models to seamlessly and naturally discretionary positions inaforementioned PUBLIC FINANCIALS™ instruments transactional exchange initiatives which involved foreign currency and interest differential arbitrage exploitation of pricing encompassing the derivative valuation of bond debt aforementioned PUBLIC FINANCIALS™ instruments with aforementioned fragmenting capital market inefficiencies. The disasterous collapse of the values comprising this derivative oriented and discretionary hedge mutual find devised a major shock wave of tempestuous exponentially debilitating systematic volatility and tempestuous exponentially detrimental increases in the costs of capital within the aforementioned fragmenting capital market inefficiencies, and eventually led to a large-scale debt oriented loan bailout package promulgated by the ancient history so-called U.S. Federal Reserve Board of Governors, ancient history so-called U.S. Federal Open Market Committee and the ancient history so-called U.S. Federal Reserve Bank. In ancient history so-called U.S. Federal Reserve Bank immediately stepped in to indemnify members of the aforementioned UNIVERSAL POPULACE™ of a large majority of devaluation aforementioned PUBLIC FINANCIALS™ instuments in this derivative oriented and discretionary hedge mutual fund with an unprecedented debt bond oriented bailout loan package that resembled the nation-to-nation economic debt bond oriented loan bailout arrangements afforded to sovereign foreign nations in Mexico and Brazil in the 1990's, and in Argentina as late as the year ending 2000. The appearance and improprietary and potential conflict of interest inclusive of, without limitation, the inappropriate, undeniable, unnecessary, unwarranted, illogical, unjustifiable, unreasoned and unmitigated and unjustifiable safety-net provisions which encompassed the debt bond oriented bailout loan package of this prominent and well-funded and well-established derivative oriented and discretionary hedge mutual fund indemnified every and all members of the aforementioned UNIVERSAL POPULACE™ which had lost billions of so-called U.S. dollar values, was that the large majority of the depositors of this high-risk derivative oriented and discretionary hedge mutual fund were banking related members of the aforementioned UNIVERSAL POPULACE™, pension fund related members of the aforementioned UNIVERSAL POPULACE™, other mutual fund members of the aforementioned UNIVERSAL POPULACE™, and select high net-worth depositors. This financial disaster distributed a major shock wave throughout the aforementioned fragmenting capital market inefficiencies indirectly and inevitably causing members of the aforementioned UNIVERSAL POPULACE™ not directly involved with the loss of billions of so-called U.S. dollar equivalent values in the derivative oriented and discretionary hedge mutual fund to lose tens of billions of so-called U.S. dollar equivalent values without any techniques, designs, systems, routines, devices, manners, modes, fashions, forms, formats, factors, objects, parts, segments, elements, components, constituents, ingredients, processes, methods and combinations of awareness, transparency, control and/or recourse as a function of the exponential devalution aforementioned PUBLIC FINANCIALS™ instruments registered and listed with aforementioned fragmenting capital market inefficiencies. In this peculiar instance, the ancient history so-called U.S. Federal Reserve Board of Governors, ancient history so-inaforementioned PUBLIC FINANCIALS™ instruments values inclusive of, without limitation, the clearing and exchange fees and charges imposed via NYSE and NASD member broker-dealers with whom the high-risk derivative oriented and discretionary hedge mutual fund had utilized as intermediaries to seamlessly and naturally its speculative and derivative oriented and computer program driven transactional exchange initiatives, schemes, ocurrences, happenings, interactions, processes, methods, practices, movements, proceedings, messaging, presentations, notifications, filings, submissions, records, activities, actions, events, endeavors, tasks and affairs, and further the high-risk derivative oriented and discretionary hedge mutual fund incorporation every and all typical fees for issuance and distribution of mutual fund shares, sales, marketing and administrative expenses, management fees and operational management charges imposed on the members of the aforementioned UNIVERSAL POPULACE™. In this specific example it is clearly an undeniable and evidentiary findings of fact, documented reference, logical scientific deduction and intuitive analytical reasoning that the ancient history so-called U.S. Federal Reserve Board of Governors, ancient history so-called U.S. Federal Open Market Committee and the ancient history so-called U.S. Federal Reserve Bank independently and arbitrarily disregarded the so-called U.S. SEC's legally vested charter under the so-called U.S. Securities Act of 1933 and so-called U.S. Securities Exchange Act of 1934, inclusive of; without limitaiton, the so-called U.S. SEC's independent supervisory oversight and governing power and authority to swiftly cover every and all of the billions in so-called U.S. dollar equivalent values which the widely recognized, well-funded and well-established high-risk derivative oriented and discretionary hedge mutual fund had lost with aforementioned fragmenting capital market inefficiencies, wherein furthermore the chairman of the ancient history so-called U.S. Federal Reserve Board of Governors, ancient history so-called U.S. Federal Open Market Committee and the ancient history so-called U.S. Federal Reserve Bank immediately addressed the so-called U.S. Congress stating emphatically that no additional supervisory oversight and governing power and authority were necessary within the aforementioned fragmenting capital market inefficiencies. Whereas, it is an undeniable and evidentiary findings of fact, documented reference, logical scientific deduction and intuitive ancient history so-called U.S. Federal Reserve Bank arbitrarily imposed interest bearing charges and interest rate oriented fees on members of the aforementioned UNIVERSAL POPULACE™ when it effectuated the inappropriate, undeniable, unnecessary, unwarranted, illogical, unjustifiable, unreasoned and unmitigated and unjustifiable safety-net provisions which encompassed the debt bond oriented bailout loan package of this prominent and well-funded and well-established derivative oriented and discretionary hedge mutual fund by indemnifying every and all members of the aforementioned UNIVERSAL POPULACE™ which had already lost billions of so-called U.S. dollar equivalent values, and of which the large majority of depositors of this high-risk derivative oriented and discretionary hedge mutual fund were banking related members of the aforementioned UNIVERSAL POPULACE™, pension fund related members of the aforementioned UNIVERSAL POPULACE™, mutual fund members of the aforementioned UNIVERSAL POPULACE™, and high net-worth depositors. Whereas, it is an undeniable and evidentiary findings of fact, documented reference, logical scientific deduction and intuitive analytical reasoning that under the limited and archaic legal charter and supervisory oversight afforded to the ancient history so-called U.S. Federal Reserve Board of Governors, ancient history so-called U.S. Federal Open Market Committee and the ancient history so-called U.S. Federal Reserve Bank this safety-net and debt bond oriented bailout loan package of this prominent and well-funded and well-established derivative oriented and discretionary hedge mutual fund by indemnifying every and all members of the aforementioned UNIVERSAL POPULACE™ which had already lost billions of so-called U.S. dollar equivalent values raised the appearance of improprietary and conflict of interest inclusive of, without limitation, being extremely inappropriate, undeniable, unnecessary, unwarranted, illogical, unjustifiable, unreasoned and unmitigated and unjustifiable because in a liquid, transparent, and efficient UNIVERSAL CAPITAL MARKET™ no one government, public or private oriented enterprise, individual or institution can serve as a safety-net provision to the debilitanting effects of systematic volatility and increases in the tempestuous exponentially detrimental impact of increases in the costs of capital. Whereas, it is an undeniable and evidentiary findings of fact, documented reference, logical scientific deduction and intuitive retransformation aforementioned fragmenting capital market inefficiencies is not a job for the so-called U.S. SEC or the so-called U.S. government because free market sovereign economies just don't work that way, and furthermore the inappropriate, undeniable, unnecessary, unwarranted, illogical, unjustifiable, unreasoned and unmitigated, and unjustifiable so-called U.S. Federal Reserve Board of Governors, so-called U.S. Federal Open Market Committee and the so-called U.S. Federal Reserve Bank initiatives, schemes, ocurrences, happenings, interactions, processes, methods, practices, movements, proceedings, messaging, presentations, notifications, filings, submissions, records, activities, actions, events, endeavors, tasks and affairs which promulgated this safety-net and debt bond oriented bailout loan package of the prominent and well-funded and well-established derivative oriented and discretionary hedge mutual find by indemnifying every and all members of the aforementioned UNIVERSAL POPULACE™ which had already lost billions of so-called U.S. dollar equivalent values with aforementioned fragmenting capital market inefficiencies is completely contrary to the basic essence of the principles of finance and economic which should govern every and all transactional exchange in a free market, highly dynamic and innately volatile global marketplace encompassing every and all of the sovereign industrialized, developed and developing economies located throughout the world. It is an evidentiary findings of fact, documented reference, logical scientific deduction and intuitive analytical reasoning thatnumerous government related members of the aforementioned UNIVERSAL POPULACE™ and banking related members of the aforementioned UNIVERSAL POPULACE™ have been involved in high-risk derivative oriented aforementioned PUBLIC FINANCIALS™ instruments transactional exchange initiatives, schemes, ocurrences, happenings, interactions, processes, methods, practices, movements, proceedings, messaging, presentations, notifications, filings, submissions, records, activities, actions, events, endeavors, tasks and affairs propagating by top-tier, major, prominent, well-capitalized, widely-recognized and traditionally established banking, securities and insurance related members of the aforementioned UNIVERSAL POPULACE™ involved in offering sales driven and commissioned oriented products and services entailing, encompassing, comprising, involving, impacting and/or effecting irresponsibility arising from the failure to recognize nor address to tremendously long-held and enormoulsy heart-felt unmet needs in the relevant art are the members of the aforementioned UNWVERSAL POPULACE™. Whereas, it is an undeniable and evidentiary findings of fact, documented reference, logical scientific deduction and intuitive analytical reasoning that an article published in the business section of the Miami Herald dated Mar. 28, 2001, reported that the ancient history chairman of the ancient history so-called U.S. Federal Reserve Board of Governors, ancient history so-called U.S. Federal Open Market Committee and the ancient history so-called U.S. Federal Reserve Bank promulgated for the first time heretofore that there is a problem with the current devaluation aforementioned PUBLIC FINANCIALS™ instruments wherefrom further he promulgated there is not enough known about how a technology and service oriented economy functions and the vast amounts of time-lagged every and all real-time processing and/or reprocessing of data and/or information receiver do not seem and/or appear to measure the right things, wherefrom further hereto the ancient history chairman stipulated the data systems in the 1950's and 1960's were at that time adequate for measurements of occurences and transactions within a global economic marketplace driven by exclusively by manufacturing production. Wherefrom further hereto the article published in the business section of the Miami Herald dated Mar. 28, 2001, reported that the ancient history chairman of the ancient history so-called U.S. Federal Reserve Board of Governors, ancient history so-called U.S. Federal Open Market Committee and the ancient history so-called U.S. Federal Reserve Bank promulgated that manufacturing production has not been the engine of the global economic marketplace for approximately twenty years heretofore, wherefrom further hereto the unparalled driver of the global economic marketplace and an ever-increasing share of gross domestic product is the value of ideas applied to problem-solving solutions entailing, encompassing, comprising, involving, impacting and/or effecting the innovative developments and technological advancements of modernized technological software products and streamlined professional digitalized services. Furthermore, the article published in the business section of the Miami Herald dated Mar. 28, 2001, reported that the ancient history chairman of the ancient history so-called U.S. Federal Reserve economic marketplace inclusive of its on-going innovative developments and technological advancements heretofore impose significant stress on government statistics, wherefrom further hereto it is therefore an undeniable and evidentiary findings of fact, documented referenece, logical scientific deduction and intuitive analytical reasoning that over no less than twenty years heretofore the inability of the ancient history chairman, the ancient history so-called U.S. Federal Reserve Board of Governors, ancient history so-called U.S. Federal Open Market Committee and the ancient history so-called U.S. Federal Reserve Bank to effectively measure every and all real-time processing and/or reprocessing of data and/or information receiver has baffled their judgement and obtrusively, arrogantly and irressponsibly left them clueless and guessing comprehensively, generally and broadly as to every and all real-time processing and/or reprocessing of data and/or information receiver in the global economic marketplace wherefrom therewith under guise heretofore multiple decades engaged in unsuitably, imprudently and obtrusively manipulating the values of the global economic marketplace in an illegal, undeniable, unnecessary, unwarranted, illogical, unjustifiable, unreasoned and unmitigated fashion at the sole expense of the members of the aforementioned UNIVERSAL POPULACE™ wherefrom hereto actualizing tempestuous exponentially detrimental increases in systematic volatility and tempestuous exponentially debilitating increases in the cost of capital within the aforementioned fragmenting capital market inefficiencies, wherefrom further hereto logically actualizing tempestuous exponential depression on the logically already diminishing returns on transactional exchanges inclusive of tempestuous exponential depression on the logically already diminishing returns on residual equities within the aforementioned fragmented UNIVERSAL ECONOMY™. It is furthermore an undeniable and evidentiary findings of fact, documented reference, logical scientific deduction and intuitive analytical reasoning that that ancient history chairman, the ancient history so-called U.S. Federal Reserve Board of Governors, ancient history so-called U.S. Federal Open Market Committee and the ancient history so-called U.S. Federal Reserve Bank heretofore have no legal chartered authority to govern, undeniably no legal right to manipulate nor the extensive training and necessary expertise to even discuss the valuation aforementioned PUBLIC the Miami Herald, dated Mar. 28, 2001, obtrusively propagating speculative spin-control on the global economic marketplace via the aforementioned inefficient UNIVERSAL CAPITAL MARKED communications booking, classifying, categorizing, adjusting, altering, revising, changing, charging, billing, collecting, producing, composing, conducting, proofing, filtering, pressing, publishing, cataloging, indexing, posting, compressing, releasing, playing, displaying, broadcasting, distributing and/or syndicating transmission, rebroadcasting, redistributing and/or resyndicating transmission, distributing and syndicating promulgation aforementioned inefficient UNIVERSAL CAPITAL MARKET™ conceptual aids as one of a vast number members of the aforementioned UNIVERSAL POPULACE™ which heretofore preclude, prevent, enthrall, pretense, harass, press, engulf, presume and oppress every and all innovative developments and technological advancements within the aforementioned fragmenting capital market inefficiencies whose general moral and logical purpose is to recognize, addresses and herewith innovatively resolve the tremendously long-held and enormously heart-felt unmet needs in the relevant art for technologial innovation which offers a comprehensively suitable, generally pertinent and broadly useful solution wherefrom hereto invoked within aforementioned UCMOST™ information technology.

7. Public Capital Market Securities

Whereas, it is an undeniable and evidentiary findings of fact, documented reference, logical scientific deduction and intuitive analytical reasoning that top-tier, major, prominent, well-capitalized, widely-recognized and traditionally established banking, securities and insurance related members of the aforementioned UNIVERSAL POPULACE™ withwith aforementioned fragmenting capital market inefficiencies are emerging as the front-runners in a world inclined toward pushing the envelope on automation and efficiency as never before seen in history and without invoking the aforementioned UCMOST™ information technology to completely resolve the tremendously long-held and enormously heart-felt unmet needs in the relevant art which are heretofore unequivocally, undeniably, logically, scientifically, intutively, completely, importune, pestiferous, condescending and insolent enthralling, hindering, entrapping, pretending, miring, fatiguing, maleficience, harassing, engulfing, pressing, malevolent, presuming, imprinting, malicious, suffocating, miring, strangling, repressing, entangling, pestering and oppressing individual members of the aforementioned UNIVERSAL POPULACE™ inclusive of propagating exponential increases in systematic volatility and exponential increases in the cost of capital thus evincing exponential depression on the diminishing returns of transactional exchanges and diminishing returns on residual equities. It is an evidentiary findings of fact, documented reference, logical scientific deduction and intuitive analytical reasoning may at first glance appear to be a positve enabling aspect of the global marketplace aforementioned PUBLIC FINANCIALS™ instruments transactional exchange initiatives, schemes, ocurrences, happenings, interactions, processes, methods, practices, movements, proceedings, messaging, presentations, notifications, filings, submissions, records, activities, actions, events, endeavors, tasks and affairs, but it is a far stretch from the truth the underlies the inherent problems which engulf the ancient history and present inefficient, ineffective, dysfunctional and aforementioned fragmenting capital market inefficiencies. For example, within an article published in the Miami Herald dated Sep. 30, 1999, it was reported by National Association of Securities Dealers (NASD) board members, that its member broker-dealers were likely to approve a US$1.0 billion plan to convert the not-for-profit NASDAQ Stock Market, Inc. owned NASDAQ, an electronic, exclusively broker/dealer controlled and licensed so-called U.S. securities exchange, to a private, closely-held, for-profit business enterprise. It was further noted that in April of 2000 the NASD members voted overwhelmingly to approve the NASD/NASDAQ restructuring proposal to raise the necessary capital funds to upgrade archaic computer information systems and allow the organization to deal more effectively with competitive for-profit enterprise challenges in the horizon. On Jun. 26, 2000, the so-called U.S. SEC approved a number of changes to NASDAQ's by-laws and charter provisions that were deemed necessary to approve the NASDAQ restructuring. These SEC approved changes placed limitations on the voting control that any one member broker-dealer is allowed to have, enacting certain provisions to ensure that shareholder protections are in place, and announced that the first phase of its private placement to raise the necessary capital funds to upgrade archaic computer information systems and allow the organization to deal more effectively with competitive for-profit enterprise challenges in the horizon had officially closed. In this private placement twenty-four million newly issued shares of common stock were sold, including twenty five million warrants to purchase additional common stock over time. The NASD also announced with the closing of this first phase of its US$1 billion private placement, that forty percent of the ownership of the NASDAQ, an electronic, exclusively member broker/dealer controlled and licensed so-called U.S. securities exchange, is now in the hands of over 2,800 depositors other than the NASD Stock Market, Inc. Ironically, +98.7% of the common stock and warrants sold by the NASD Stock Market Inc. in the NASDAQ were offered strictly to 2,764 NASD exclusively member broker/dealers. Of this first phase of the NASDAQ private placement only +1.3% of the newly issued common stock and warrants were available to active NASDAQ participants and no offering of the electronic, exclusively member broker/dealer controlled and licensed so-called U.S. securities exchange was made available to members of the aforementioned UNIVERSAL POPULACE™. On Jun. 28, 2000, the NASD Stock Market, Inc., chairman and chief executive officer announced to members of the aforementioned UNIVERSAL POPULACE™ that the NASDAQ will be independently owned by marketplace participants, shall have the capital needed to fuel growth, and have the board capacity, experience and decision-making ability to move quickly to react to competitive challenges. A second phase of the private placement in NASDAQ, electronic, exclusively member broker/dealer controlled and licensed so-called U.S. securities exchange in an effort to acquire the expected U.S$1 billion was anticipated to be completed by the fall of 2000. Whereas, it is reported that the NASD, which supposedly previously owned +100% of the NASDAQ Stock Market, Inc., that it is only anticipated to retain less than a thirty-three percent stake in the NASDAQ, electronic, exclusively member broker/dealer controlled and licensed so-called U.S. securities exchange. Now, it is clearly an undeniable and evidentiary findings of fact, documented reference, logical scientific deduction and intuitive analytical reasoning that statements disseminated to members of the aforementioned UNIVERSAL POPULACE™ into believing the NASDAQ, electronic, exclusively member broker/dealer controlled and licensed so-called U.S. securities exchange, is somehow to be owned by members of the aforementioned UNIVERSAL POPULACE™ from around the world. This is simply not correct, accurate or truthful because the NASDAQ, electronic, exclusively member broker/dealer controlled and licensed so-called U.S. securities exchange even after the completion of the so-called U.S. SECond phase of the private placement is not designed to be owned in every and all forms, parts, means and segements by owned by members of the aforementioned UNIVERSAL POPULACE™ from around the world. In direct contrast to the statements made to members of the aforementioned UNIVERSAL POPULACE™ by the NASD Stock Market, Inc. the NASDAQ, electronic, exclusively member broker/dealer controlled and licensed so-called U.S. securities exchange has always been and shall hereto remain an electronic, exclusively member broker/dealer controlled and licensed so-called U.S. securities exchange. Furthermore, it is clearly an undeniable and evidentiary findings of fact, documented reference, logical scientific deduction and intuitive analytical reasoning that the NASD Stock Market, Inc., is and always has been a exclusive membership oriented broker-dealer operated, subsidized and managed public organization, and its selling off of +98.7% of the newly issued common stock and warrants to it's own exclusive membership of broker-dealers does in every and all forms, parts, means and segements create, induce or lead to any statistically significant independence of the NASDAQ, electronic, exclusively member broker/dealer controlled and licensed so-called U.S. securities exchange. Moreover, the emergence of electronic trading ESTNs, whose advent was a result of back-office institutional program trading devised specifically to enable transactional exchange banking firms to capitalize on the concepts of arbitrage pricing differentials concretizing because of the inefficient, ineffective, dysfunctional and aforementioned fragmenting capital market inefficiencies via invoked within aforementioned UCMOST™ information technology concretizes automatizing real-time holistically steady state synchronized ubiquitous continuum real-time rhombus microprocessing instantaneous transmission and receiver transforming traverse conduit aforementioned UCMOST™ real-time processing and/or reprocessing of data and/or interactions, processes, methods, practices, movements, proceedings, messaging, presentations, notifications, filings, submissions, records, activities, actions, events, endeavors, tasks and affairs. The capital transactional exchange funding for ESTNs has come from the transactional exchange banking industry, so-called U.S. licensed securities exchanges, transactional exchange banking organizations, pension managers, mutual funds and insurance companies operating and/or residing in the so-called U.S. or in foreign territories. Whereas, it is reported within an article published in the Miami Herald dated Dec. 15, 1999, that the comprehensively illegal, generally imprudent and broadly useless prevailing utilization of selective disclosure via aforementioned fragmenting capital market inefficiencies, affects everyone with a stake in the stock market whom are evidently, undeniably, logically, technically, scientifically and intutively heretofore oppressed, repressed, castigated and preyed upon via use of this traditonal method of selective disclosing data and/or information within a capital market; wherefrom it was further reported that a previously published survey conducted by the so-called Investment Company Institute (ICI) and the so-called U.S. SEC Industry Association (SIA), the two, major, prominent, well-funded and traditioanlly established and outspoken representative interest groups of the so-called U.S. SEC industry, recently made public that they believe nearly eighty million people own PUBLIC FINANCIALS™ instruments, which is an increase of +86% in actual individuals from those which supposedly owned aforementioned PUBLIC FINANCIALS™ instruments as of 1983. Ironically, the article published in the Miami Herald are comprehensively suitable, generally pertinent and broadly useful to these issues and matters pertaining to selective disclosure went on to describe that the many present members of the aforementioned UNIVERSAL POPULACE™, presumably inclusive of without limitation, every and all present senior executives, board directors, audit committee members, independence committee members, compensation committee members, midlevel executive managers, personnel employees, internal auditors, public accountants, independent auditors, legal counsel, and/or every and all forms of institutional money managers, financial analysts, so-called U.S. licensed aforementioned PUBLIC FINANCIALS™ instruments exchanges, so-called U.S. aforementioned PUBLIC UNIVERSAL CAPITAL MARKET™ banking administrative authorities, so-called U.S. state oriented UNIVERSAL CAPITAL MARKET™ insurance administrative authorities, so-called U.S. state oriented aforementioned PUBLIC FINANCIALS™ instruments administrative authorities, members of the aforementioned UNIVERSAL POPULACE™, and/or every and all hereto members of the aforementioned UNIVERSAL POPULACE™ encompassing and/or involved in the banking, insurance and securities industries and sectors or therewithal involved in the distinctively separate and traditionaly exclusive specialty areas of involving public accounting, transport reconciling, independent auditing, financial reporting and/or order-entry quotation, matching, clearance, execution, settlement and exchange of insurance, risk financing, credit, cash management, investment banking and aforementioned PUBLIC FINANCIALS™ instruments transactional exchange initiatives do not have timely access to aforementioned PUBLIC FINANCIALS™ statements in connection with aforementioned PUBLIC FINANCIALS™ instruments from members of the aforementioned UNIVERSAL POPULACE™ which inevitably are logical participants with aforementioned fragmenting capital market inefficiencies. One chief executive officer of a money management firms which maanges US$75 million in Tulsa, Oklahoma was quoted as stating specifacally that the playing field isn't level because some members of the aforementioned UNIVERSAL POPULACE™ are more equal than others, and there's no sign that this historical distinction will change anytime soon under the present structural foundation which involves the vast network of exclusive intermediary members of the aforementioned UNIVERSAL POPULACE™ which enthrall public organiations and members of the aforementioned UNIVERSAL POPULACE™ with the ancient history and present inefficient, ineffective, dysfunctional and aforementioned fragmenting capital market inefficiencies. The article goes on to quote a reference from another senior executive of a public organization which is involved in managing US$2.4 billion with aforementioned fragmenting capital market inefficiencies, who was quoted as stating emphatically that some members of the aforementioned UNIVERSAL POPULACE™ get invited to meetings concerning aforementioned PUBLIC FINANCIALS™ statements inclusive of seamlessly and senior executive followed up his commentary stating that that is just the way corporate America has worked historically albeit in contrast to the legal precedent of seventy-years of so-called U.S. securities laws, governing rules and authoritative regulations which specifically set forth a prohibition against these forms of behavior. The article further mentions that the present SEC Chairman Arthur Levitt is blunt and adamant in his condemnation of the ties between so-called Wall Street oriented NYSE and NASD member broker-dealers and the senior executives members of the aforementioned UNIVERSAL POPULACE™ which are logical participants with aforementioned fragmenting capital market inefficiencies. The article went on to mention that selective disclosure takes on a new meaning in an new era when more members of the aforementioned UNIVERSAL POPULACE™, amateur traders and members of the aforementioned UNIVERSAL POPULACE™ are making their ownaforementioned PUBLIC FINANCIALS™ instruments transactional exchange decision initiatives, schemes, ocurrences, happenings, interactions, processes, methods, practices, movements, proceedings, messaging, presentations, notifications, filings, submissions, records, activities, actions, events, endeavors, tasks and affairs. For example within an article published in the Miami Herald dated Feb. 28, 2001, it was reported that the Trustees of the Florida Retirement System unanimously approved a newly enacted transactional exchange policy which opens the door for the present so-called Wall Street oriented NYSE and NASDAQ member broker-dealer organizations and their vast network of exclusive intermediary members of the aforementioned UNIVERSAL POPULACE™ to sell aforementioned PUBLIC FINANCIALS™ instruments to nearly 650,000 state personnel public service employees. The newly casts votes to change the present sole defined-benefit pension plans of historical days involving state personnel public service employees, which will continue as is, will now be supplemented by so-called 401(a) defined-contribution retirement transactional exchange plans similar in letter, spirit, nature, scope, breadth and depth to the 401(k) defined-contribution retirement transactional exchange plans sponsored by private sector oriented members of the aforementioned UNVERSAL POPULACE™. The article specifies that the State of Florida's Governor Jeb Bush, State of Florida Treasurer Tom Gallagher and State of public service employees, and noted that this historic move by a so-called U.S. state of the union of america opens up a bidding contest between present so-called Wall Street oriented NYSE and NASDAQ member broker-dealer organizations and their vast network of exclusive intermediary members of the aforementioned UNIVERSAL POPULACE™, wherein it is present anticipated that nearly US$13 billion in retirement plan transactional exchanges may be channeled directly by state personnel public service employees into PUBLIC FINANCIALS™ instruments. Interestingly, the article published in the Miami Herald dated Dec. 15, 1999, concerning selective disclosure of public financial statement and PUBLIC FINANCIALS™ instruments, specifies that members of the aforementioned UNIVERSAL POPULACE™ from around the world which are heretofore utilizing on-line accounts to seamlessly and naturally their own transactional exchange initiatives involving aforementioned PUBLIC FINANCIALS™ instruments as of the date of the article publication represented nearly +17% of every and all obscurant, irresponsible, feculent, irrational, feckless, disrespectful mendacious, ignorant, malicious, condescending, untruthful, insolent, inefficient, incognizant, ineffective, fragmenting, unlettered, unpolished, presumptuous, portentous, pretentious, fruitless, disparate, antiquated, archaic, ancient history and superannuated so-called U.S. securities transactional exchange orders effectuated on a daily basis. Whereas, it is an undeniable and evidentiary findings of fact, documented reference, and logical scientific deduction reasoning that the world of information technology is imminently facilitating a holistic econometric capital market environment concretizing via consummate resolution and constructive reduction to practice via aforementioned UCMOST real-time processing and/or reprocessing, an exponentially more conducive marketplace evincing enhanced fairness, simulteanoues equality, full transparency, consolidated access and perpetual integration to aforementioned PUBLIC FINANCIALS™ statements in connection with and/or combined with aforementioned PUBLIC FINANCIALS™ instruments from members of the aforementioned UNIVERSAL POPULACE™; whereas, enabling all members of the aforementioned UNIVERSAL POPULACE™ from around the world to seamlessly and naturally effectuate their own transactional exchange initiatives involving the purchase and/or sale aforementioned PUBLIC FINANCIALS™ instruments. aforementioned PUBLIC FINANCIALS™ instruments via 401(a) deferred-contribution retirement transactional exchange plans simply underscores the importance for every and all enhanced fairness, simulteanoues equality, full transparency, consolidated access and perpetual integration to aforementioned PUBLIC FINANCIALS™ statements in connection with aforementioned PUBLIC FINANCIALS™ instruments from members of the aforementioned UNIVERSAL POPULACE™ inclusive of the necessary incorporation of full and fair disclsoure, best practices and best executions in every and all aforementioned PUBLIC FINANCIALS™ instruments transactional exchange initiatives, schemes, ocurrences, happenings, interactions, processes, methods, practices, movements, proceedings, messaging, presentations, notifications, filings, submissions, records, activities, actions, events, endeavors, tasks and affairs, and which thereupon eradicating every and all techniques, designs, systems, routines, devices, manners, modes, fashions, forms, formats, factors, objects, parts, segments, elements, components, constituents, ingredients, processes, methods and combinations of selective disclosure and the inefficient, ineffective, dysfunctional and fragmented structural foundation found prevalent with aforementioned fragmenting capital market inefficiencies. Whereas, it is an undeniable and evidentiary findings of fact, documented reference, and logical scientific deduction reasoning that the senior executives members of the aforementioned UNIVERSAL POPULACE™ must inevitably prepare to adapt to a new and higher standars of full disclosure, best practices, best executions, enhanced fairness, simultaneous equality, full transparency, consolidated access and perpetual integration of members members of the aforementioned UNIVERSAL POPULACE™ involving the distinctively separate and traditionally exclusive specialty areas involving public accounting, transport reconciling, independent auditing and financial reporting inclusive of, without limitation, order-entry quotation, matching, clearance, execution, settlement and exchange of insurance, risk financing, credit, cash mangement, transactional exchange banking and aforementioned PUBLIC FINANCIALS™ instruments transactional exchange initiatives. It is a clear and undeniable evidentiary findings of fact, documented reference, logical scientific deduction and intutive analytical reasoning that the accuracy, quality, integrity, honor, timeliness, relevance, transparency, reliabilty, information content management, financial services and aforementioned PUBLIC FINANCIALS instrument transactional activities whence offered to hundreds of millions of members of the aforementioned UNIVERSAL POPULACE™ sustains the treasure accounting, financial fueling and econometric energizing of a healthy, lean, strong, vibrant and expanding aforementioned efficient UNIVERSAL CAPITAL MARKET™, wherefrom dependent exclusively on the unifying creativity, humility nuturing and long-term employment capacity of the work force of planet earth. The lifeblood of an aforementioned efficient UNIVERSAL CAPITAL MARKET™ encompasses the specialty areas of the efficient, effective, functional and integrated streamlined, alternating scale, inseparable, seamless and natural wrapping, interlacing, coiling, coupling, combining and interlocking techniques, designs, systems, routines, devices, manners, modes, fashions, forms, formats, factors, objects, parts, segments, elements, components, constituents, ingredients, processes, methods and combinations entailing, encompassing, comprising, involving, impacting and/or effecting automatizing real-time holistically steady state synchronized ubiquitous continuum real-time rhombus microprocessing instantaneous transmission and receiver transforming traverse conduit aforementioned UCMOST™ real-time processing and/or reprocessing of every and all public accounting, transport reconciling, independent auditing and financial reporting inclusive of efficient, effective, functional and integrated streamlined, alternating scale, inseparable, seamless and natural wrapping, interlacing, coiling, coupling, combining and interlocking techniques, designs, systems, routines, devices, manners, modes, fashions, forms, formats, factors, objects, parts, segments, elements, components, constituents, ingredients, processes, methods and combinations entailing, encompassing, comprising, involving, impacting and/or effecting automatizing real-time holistically steady state synchronized ubiquitous continuum real-time rhombus microprocessing instantaneous transmission and receiver transforming traverse conduit aforementioned UCMOST™ real-time processing and/or reprocessing of every and all order-entry quotation, matching, clearance, execution, settlement and exchange of insurance, risk financing, credit, cash management, investment banking, and PUBLIC FINANCIALS™ instruments transactional activities. To underscore the need for novel and innovative panacean processing and/or reprocessing of data and/or information concretized, ebroidered, leveraged and harnessed within the real-time universal microprocessor computer utitlity and design provisions within th eaforementioned UCMOST information technologies which may potentially be offered to hundreds of millions of individual members of the aforementioned UNIVERSAL POPULACE™, it is important to consider and review the case-study example of a world-leading promotional marketing and franchise company with ownership rights to well-recognized brand-names, in discount membership subscriptions, hotel bed franchise and retail management, rental automobile outlet operations and real-estate brokerage mortgage/agency services which was formed in December 1997 with the onset of a merger between two regional albeit world-class members of the aforementioned UNIVERSAL POPULACE™ in the respective industries and sectors in the global marketplace environemnt. Therefrom, within an article published in the Miami Herald business section dated Dec. 10, 1999, it was reported that subsequent to effectuating purchases of the merged public organization's registered, listed and exchanged PUBLIC FINANCIALS™ instruments, plaintiffs eventually found themselves in court with the merged public organization claiming that a major division of a segment part of the merged public organization had previously engaged in practicing (i) accounting irregularities are comprehensively suitable, generally pertinent and broadly useful to the overbooking, or booking in advance, of revenues in one of the discount membership subscription operations, leading to a one-time US$500 million restatement of the PUBLIC FINANCIALS™ statements of the merged public organization are comprehensively suitable, generally pertinent and broadly useful to the previously disseminated earnings profitability of the merged public organization which had been filed for submission for the previous three years pertaining to the year-ending 1995-1997. In the pertinent legal proceedings, plaintiffs also accused the merged public organization of disclosing (ii) false and misleading information, (iii) failure to disclose material information, and (iv) allowing directors and executive officers to sell stock equity shares of the merged public organization before announcing and/or disseminating the accounting irregularities to other members of the aforementioned UNIVERSAL POPULACE™, which inevitably concretizing allegations of insider trading within the public organization. Furthermore, it is clearly an undeniable and evidentiary findings of fact, documented reference, logical scientific deduction and intuitive analytical reasoning that in a single limited after-hours trading session, the aforementioned PUBLIC FINANCIALS™ instruments of the merged public organization realized a US$14.5 billion loss in valuation with no recourse to members of the aforementioned UNIVERSAL POPULACE™ holding stock equity positions in the merged public organizaation. This financial disaster was followed by ridiculous disbeliefat major, extremely prominent, widely recognized and well-established traditional banking, securities and insurance oriented members of the aforementioned UNIVERSAL POPULACE™ and their subsidiary branches and sales commissioned account executives who had under the guise of not knowing or being informed, until after the financial disaster, apparently analyzed the mergers value based on logically dated, false and misleading financial information. Nevertheless, these major, extremely prominent, widely recognized and well-established traditional banking, securities and insurance oriented members of the aforementioned UNIVERSAL POPULACE™ and their subsidiary branches and sales commissioned account executives had continously touted, marketed, purported, bolstered, brokered and sold stock equity in the merged public organization in large numbers from 1995 to 1998. With limited recourse at the very least members of the aforementioned UNIVERSAL POPULACE™ are now being offered nominal retribution for having suffered financially in one of the most dramatic and sustained losses in the market valuation of amembers of the aforementioned UNIVERSAL POPULACE™ registered, listed and exchanged by within the aforementioned fragmenting capital market inefficiencies during all of 1998. At the time, the merged public organization stock equity holdings in ledger account balances owned by medium to high-risk members of the aforementioned UNIVERSAL POPULACE™ would likely have included a position in this UNIVERSAL CAPITAL MARKET™ security as it quickly became one of the most actively marketed and traded securities within the aforementioned fragmenting capital market inefficiencies on numerous occasions. It is a clear and undeniable findings of fact, documented reference, logical scientific deduction and intuitive analytical reasoning that it is completely unacceptable to an overnight loss of approximately US$14.5 billion in capital market value involving the aforementioned PUBLIC FINANCIALS™ instruments of the merged public organization, thus providing an evidentiary logical basis and justifiable reasoning for perpetually striving toward mitigating tempestuous and detrimental increases in systematic volatility inclusive of tempestuous and debilitating increases of cost of capital by constraining every and all aforementioned fragmenting capital market inefficiencies from a capital market. Within an article published in the Miami Herald dated Mar. 1, 2001, it was reported that the so-called U.S. SEC has filed a civil enforcement action against the two former highest ranking senior executive officers for falsely inflating the value of a segment part of the direct marketing organization which sold memberships in discount buying clubs which became a part and form of the eventually merged public organization devised in December 1997. As previously noted, the merged public organization had evidently engaged in fraudulent account manipulation pertaining to overstating operating income for 1997 by as much as US$170 million which eventually devised the sigle day loss in the value of the aforementioned PUBLIC FINANCIALS™ instruments of the merged public organzation by US$14.5 billion, in what eventually became a major UNIVERSAL CAPITAL MARKET™ scandal that became the largest financial fraud case ever pursud and prosecuted by the so-called U.S. SEC. The conclusive evidence of this major financial fraud case subsequently led to a record US$2.83 billion settlement of a class-action shareholder lawsuit against the merged public organization and its two former highest ranking senior executive officers. The two former highest ranking senior executive officers of the direct marketing public organiation which eventually became a part and form of the merged public organization were eventually elected as chairman of the board and chief operating officer for merged public organization are to be arraigned on charges of conspiracy and wire fraud charges by the so-called U.S. Attorney's Office, and if convicted on the allegations made by the so-called U.S. SEC each of the two former high-ranking senior executives face up to 10 years in prison and US$500,000 in civil fines. Furthermore, the so-called U.S. SEC accuses the two former senior executive officers of directing a financial fraud scheme to overstate the revenues of the public organization which eventually became a part and all stock gains which they may have accumulted from the time of ther merger inclusive of, without limitation, paying additional penalties, and it was further reported that three other former lower-level albeit high-ranking senior executive officers of the public organization which eventually became a part and form of the merged publlc organization already pleaded guilty in the accounting and financial fraud scandal. In a similarly comprehsively relevant topis, issue and matter concerning irregulatiries in assuming risk and so-called world-class financial scandalizing within the heretofore capital market, a government related public organization from the State of California in the so-called U.S., and one of the oldest and major, extremely prominent, widely-recognized and well-established banking related members of the aforementioned UNIVERSAL POPULACE™ in Europe each respectively resulted in financial insolvency due to undeniable, unnecessary, unwarranted, illogical, unjustifiable, unreasoned and unmitigated risks that were assumed and authorized by managers at these respective institutions. Accordingly, the government related public organization fell into deep economic troubles due to their positions in derivative oriented PUBLIC FINANCIALS™ instruments, but yet retains in existence because of its status as a public organization. On the other hand, one of the oldest and major, extremely prominent, widely-recognized and well-established banking related members of the aforementioned UNIVERSAL POPULACE™ in Europe collapsed as a public organization within a matter of days as a direct function of these high-risk derivative transactional exchange in the ancient history and present inefficient, ineffective, dysfunctional and aforementioned fragmenting capital market inefficiencies. Whereas, it is an undeniable and evidentiary findings of fact, documented reference, logical scientific deduction and intuitive analytical reasoning that both instances are classic detailed examples of the problems associated with utilizing derivative PUBLIC FINANCIALS™ instruments, whether speculatively, conservatively, or otherwise with aforementioned fragmenting capital market inefficiencies. Furthermore, because derivative aforementioned PUBLIC FINANCIALS™ instruments are off-balance sheet accounting and financial reporting items on the PUBLIC FINANCIALS™ statements members of the aforementioned UNIVERSAL POPULACE™ they pose increasingly enormous risk to the balance sheet valuations otherwise, and present these derivative oriented aforementioned PUBLIC FINANCIALS™ instruments are not readily identifiable in the present PUBLIC FINANCIALS™ statements presented to members of the aforementioned UNIVERSAL POPULACE™ because they are mere footnote disclosures. Additionally, some derivative oriented and typically off-balance sheet aforementioned PUBLIC FINANCIALS™ instruments display the capacity to very quickly become liabilities at any point in time throughout the existence of their maturity period, and furthermore some aforementioned PUBLIC FINANCIALS™ instruments do not incorporate stop-loss provisions that protect against unlimited liabilities to the PUBLIC FINANCIALS™ statements of the members of the aforementioned UNIVERSAL POPULACE™ which may have inevitably been the case with the government related public organization in the State of California in the so-called U.S., and one of the oldest and major, extremely prominent, widely-recognized and well-cstablished banking related members of the aforementioned UNIVERSAL POPULACE™ in Europe. To further reiterate the tempestuous exponentially detrimental impact of utilizing inappropriate derivative oriented PUBLIC FINANCIALS™ instruments, and further in example of every and all continued and perpetual harming, damaging, inuring, insistent, insinuating, imposing, pestilent, impetuous, importune, pestiferous, condescending and insolent enthralling, hindering entrapping, pretending, miring, fatiguing, maleficience, harassing, engulfing, pressing, malevolent, presuming, imprinting, malicious, suffocating, miring, strangling, repressing, entangling, pestering and oppressing individual members of the aforementioned UNIVERSAL POPULACE™ which are traditionally concretizing via inefficient, ineffective, dysfunctional and fragmented vast networks of antiquated, archaic, ancient history and superannuated aforementioned PUBLIC FINANCIALS™ organizations which heretofore continuously, arrogantly, imprudently, irrationally and irresponsibly engage in propagating aforementioned fragmenting capital market inefficiencies via the communicating conduits of conceptual aids within a single holistically econometric marketplace environment. Whereas, it is an undeniable and evidentiary findings of fact, documented reference, logical scientific reasoning and intuitive analytical reasoning that every and all of the aforementioned further involve, unreasoned and unmitigated, illogical, unjustifiable and unreasoned systematic volatility and mitigating increases in the cost of capital therein, the so-called U.S. SEC and so-called U.S. Attorney's Office recently began inquiries into bribes of public officials in a neighboring government related public organization in the State of California in the so-called U.S. in exchange for fees and excessive commissions on more than US$7.5 billion inaforementioned PUBLIC FINANCIALS™ instruments transactional exchange initiatives handled by one major, extremely pominent, well-capitalized and well-established NYSE and NASD member broker-dealer. Apparently, this particular government relatd public organizaton is a geographical neighbor to the aforementioned government related public organization in the State of California in the so-called U.S., wherein as aforementioned in 1994 this government related public organization realized enormoug losseg on the impudent advice and counsel of one major, extremely porninent, well-capitalized and well-established banking, securities and insurance related public organization which is a member broker-dealer of the present so-called U.S. licensed NYSE and NASD exchanges. It is an evidentiary findings that so-called Wall Street account executives bated the aforementioned government related public organization into purchasing unsuitable and inappropriate derivative aforementioned PUBLIC FINANCIALS™ instruments creating losses of billions of dollars, and ultimately thereof resulting in that government related public organization inevitably falling into unprecedented bankruptcy proceedings. The so-called U.S. SEC and the so-called U.S. Attorney's Office recently started an depositigative inquiry in to the neighboring government related public organization after a civil lawsuit was filed against one major, extremely porninent, well-capitaized and well-established NYSE and NASD) member broker-dealer. The neighboring government related public organization lawsuit against the heretofore major, extremely pominent, well-capitalized and well-established NYSE and NASD member broker-dealer alleges that one of its leading nine-year veteran commission oriented account executive bribed public officials with cash payments, trips to foreign countries, entertainment outings and dinners for aforementioned PUBLIC FINANCIALS™ instruments transactional exchange initiatives, schemes, ocurrences, happenings, interactions, processes, methods, practices, movements, proceedings, neighboring government related public organization lawsuit stipulated that in exchange for the illegal bribes for transactional so-called U.S. Securities Exchange Act of 1934ivity contracts with the government related public organization, the account executive employed by the heretofore major, extremely pominent, well-capitalized and well-established NYSE and NASD member broker-dealer charged the neighboring government related public organization excessive commissions and bated It into purchasing inappropriate and unsuitable derivative, stock equity and bond debt orieented aforementioned PUBLIC FINANCIALS™ instruments wherein the economic and financial losses assumed by the neighboring government related public organization approximated US$30 million. The Treasury-Tax collector for neighboring government related public organization recently asserted, in response to the alleged bribes from the account executive employed by the heretofore major, extremely pominent, well-capitalized and well-established NYSE and NASD member broker-dealer, that no one should be allowed to bribe or even attempt to bribe government related public officials and the nature of these pertinent charges violates rules of the Municipal Securities Rulemaking Board (MSRB) that prohibit dishonest, deceptive or unfair practices. The neighboring government related public organization lawsuit, inclusive of, without limitation, the so-called U.S. SEC and so-called U.S. Attorney's Office Investigations stemmed from a Federal Bureau of Investigation (FBI) inquiry that uncovered a series of unrelated fraud and bribery initiatives, schemes, ocurrences, happenings, interactions, processes, methods, practices, movements, proceedings, messaging, presentations, notifications, filings, submissions, records, activities, actions, events, endeavors, tasks and affairs surrounding various public contracts of the neighboring government related public organization which did not involve aforementioned PUBLIC FINANCIALS™ instruments transactional exchange initiatives, schemes, ocurrences, happenings, interactions, processes, methods, practices, movements, proceedings, messaging, presentations, notifications, filings, submissions, records, activities, actions, events, endeavors, tasks and affairs, but nonetheless resulted in the resignation of public elected and appointed public officials at the neighboring government related public organization. These alleged bribes, kickbacks and unsuitable transactional exchanges involving NYSE and a lack of supervisory oversight capacity are comprehensively suitable, generally pertinent and broadly useful to the self-regulatory role of the so-called U.S. SEC industry in perpetually serving the best interests members of the aforementioned UNIVERSAL POPULACE™, which may be directly related to their historical and traditionally failure to integrated and require steadfast adherence and full compliance to every and all requisite transnational, constitutional, federal, state, and local laws, and applicable executive orders, legislative acts and statues, governing rules and authoritative regulations of every and all independent regulatory bodies and governing authorities present existent with aforementioned fragmenting capital market inefficiencies. In evidence that many so-called fraudulent schemes involving every and all techniques, designs, systems, routines, devices, manners, modes, fashions, forms, formats, factors, objects, parts, segments, elements, components, constituents, ingredients, processes, methods and combinations are comprehensively suitable, generally pertinent and broadly useful aforementioned PUBLIC FINANCIALS™ instruments involve members of the aforementioned UNIVERSAL POPULACE™ which may not necessarily be considered major, extremely prominent, well-established and well-capitalized members of the aforementioned UNIVERSAL POPULACE™ but which still entail, encompass and comprise initiatives, schemes, ocurrences, happenings, interactions, processes, methods, practices, movements, proceedings, messaging, presentations, notifications, filings, submissions, records, activities, actions, events, endeavors, tasks and affairs via adaptive evolution of the aforementioned fragmenting capital market inefficiencies, it was recently reported within an article published in the business section of the Miami Herald dated Jan. 12, 2001, that various government related multi-agency task force crackdowns on fraud related initiatives, schemes, ocurrences, happenings, interactions, processes, methods, practices, movements, proceedings, messaging, presentations, notifications, filings, submissions, records, activities, actions, events, endeavors, tasks and affairs applicable to foreign currency trading oriented derivative aforementioned PUBLIC FINANCIALS™ instruments transactional exchange evinced indictment and immediate shut downs to protect the interests of the public. Apparently, in these varying allegations of fraudulent scheme initiatives, schemes, ocurrences, happenings, interactions, and affairs named defendants included four proprietors of US$18 million worth of fraudulent foreign currency trading scheme which was located in Pompano Beach and Miami in the State of Florida in the so-called U.S. Although, the allegations in question when considered individually were not exceptionally large in dollar values nevertheless in aggregate collective fashion they they shed enormous light on the varying fraudulent scheme initiatives, schemes, ocurrences, happenings, interactions, processes, methods, practices, movements, proceedings, messaging, presentations, notifications, filings, submissions, records, activities, actions, events, endeavors, tasks and affairs involved with aforementioned fragmenting capital market inefficiencies, and furthermore because the named defendents in these cases are confronting potential criminal indictments, rather than merely civil charges as has been historically the case involving white-collar fraudulent schemes entailing, encompassing, comprising, involving, impacting and/or effecting aforementioned PUBLIC FINANCIALS™ instruments transactional exchanges initiatives, schemes, ocurrences, happenings, interactions, processes, methods, practices, movements, proceedings, messaging, presentations, notifications, filings, submissions, records, activities, actions, events, endeavors, tasks and affairs they received heightened attention from public audiences. It was therein reported by the local so-called U.S. Attorney, who has flanked by the regional heads of the so-called U.S. Treasury, so-called U.S. SEC, the FBI and the so-called U.S. Postal Service that members of the aforementioned UNIVERSAL POPULACE™ are literally losing their specified life, health, property, casualty, liabilities, valuables and/or factors, things, elements and/or courses of initiatives, schemes, ocurrences, happenings, interactions, processes, methods, practices, movements, proceedings, messaging, presentations, notifications, filings, submissions, records, activities, actions, events, endeavors, tasks and affairs and retirement savings at the hands of these so-called white-collar criminals whose fraudulent schemes are getting bigger and more complex. The so-called U.S. Attorney called the informal government related multi-agency task force the most comprehensive aforementioned PUBLIC FINANCIALS™ instruments fraud effort undertaken in South Florida while only similar teamwork efforts have only been formed in San Francisco in the State of California and New York City in the State of New York, each in the fraud hatchery. The informal team described that aforementioned PUBLIC FINANCIALS™ instruments fraud has grown to near epidemic proportions, targeting the most vulnerable members of the community, inclusive of, without limitation, members of the aforementioned UNIVERSAL POPULACE™. The largest case announced in the Miami Herald article involved a local NASD member broker-dealer public organization which boasted, marketed, bolstered, purported and touted +6% monthly profits from the trading of foreign currency oriented PUBLIC FINANCIALS™ instruments. The local NASD member broker-dealer public organization had ironically and apparently been shut down by a so-called U.S. federal judge in September of 1998 at the request of the so-called U.S. SEC, and the four men involved in the fraudulent scheme at the local NASD member broker-dealer public organization are now charged with money laundering, conspiracy, mail fraud and wire fraud. One of the conspirators had been charged by the so-called U.S. SEC on a 1997 separate case and was fined US$100,000 and barred from the aforementioned PUBLIC FINANCIALS™ instruments business only one month before forming the local NASD member broker-dealer public organization. The so-called U.S. Attorney explained that it more than two years to press criminal charges against the proprietors involved in the local NASD member broker-dealer public organization fraudulent scheme involving foreign currency oriented derivative aforementioned PUBLIC FINANCIALS™ instruments because regulators needed to pursue careful Investigations which often involve interviewing the victims, going via records and following the money trail which are often the aforementioned so-called correspondent banking relatd offshore accounts. Another case reported in the Miami Herald article involved a two men from Miami and Boca Raton who were accused on running an oil-and-gas drilling fraudulent aforementioned PUBLIC FINANCIALS™ instruments scheme that bilked 105 members of the aforementioned UNIVERSAL POPULACE™ from around the so-called U.S. out of US$1.7 million, while another case involved a 46-count indictment against two men from Palm Beach Gardens and Jupiter involving a so-called pump-and-dump stock equity oriented fraudulent aforementioned PUBLIC FINANCIALS™ instruments scheme which led to losses of US$3 million from October 1998 to June 1999, wherein the named defendants allegedly duped members of the stock equity valuation of that instrument upward and discouraging members of the aforementioned UNIVERSAL POPULACE™ from selling their positions within the aforementioned PUBLIC FINANCIALS™ instruments while insiders of the public organization sold out their positions. Yet another case announced by the informal government related multi-agency task force involved a man from the city of Miami in the State of Florida in the so-called U.S. who was accused of arranging for a stand-in to take NYSE and NASD commissioned oriented account executive licensing exams, and when the substitute passed the licensing examinations the named defendant posed as a commission oriented account executive at an NASD member broker-dealer located in Miami. Furthermore, in a vivid display of the prevalence of foreign oriented promulgation of continued and perpetual harming, damaging, inuring, insistent, insinuating, imposing, pestilent, impetuous, importune, pestiferous, condescending and insolent enthralling, hindering, entrapping, pretending, miring, fatiguing, maleficience, harassing, engulfing, pressing, malevolent, presuming, imprinting, malicious, suffocating, miring, strangling, repressing, entangling, pestering and oppressing individual members of the aforementioned UNIVERSAL POPULACE™ which are traditionally concretizing via inefficient, ineffective, dysfunctional and fragmented vast networks of antiquated, archaic, ancient history and superannuated aforementioned PUBLIC FINANCIALS™ organizations which heretofore continuously, arrogantly, imprudently, irrationally and irresponsibly engage in propagating aforementioned fragmenting capital market inefficiencies via the communicating conduits of conceptual aids within a single holistically econometric marketplace environment. Whereas, it is an undeniable and evidentiary findings of fact, documented reference, logical scientific reasoning and intuitive analytical reasoning that every and all of the aforementioned further involve, concern and pertain to every and all techniques, designs, systems, routines, devices, manners, modes, fashions, forms, formats, factors, objects, parts, segments, elements, components, constituents, ingredients, processes, methods and combinations aforementioned PUBLIC FINANCIALS™ statements seamlessly and naturally wrapped, twisted, mixed, convoluted, embroidered and combined in connection with aforementioned PUBLIC FINANCIALS™ instruments from members of the aforementioned PUBLIC FINANCIALS™ instruments transactional exchange information in the W.W. capital markets, it was reported within an article published in the business section of the Miami Herald dated Jan. 12, 2001, that a Chilean family business group which runs an enterprise holding company asked a criminal court in the country of Chile to depositigate a fraudulent letter which announced a false tender offer by the enterprise holding company pertaining to the possibility of entering into further business ownership positions in a national sovereign non-government bank. The attorney for the family business group enterprise holding company, reported this office and Chile's securities regulators were dopositigating where the fraudulent, phony and hoax letter, which embodied a false stamp by Chile's securities regulators and a forged signature of the Chief Executive Officer of the enterprise holding company and Chile's securities regulators, orginate from and depositigative results were pointing to a former clerk at the offices of Chile's securities regulators. The enterprise holding company's attorney led depositigative efforts pertaining to the fraudulent, phony and hoax letter further promulgated an depositigative probe which had been started by Chile's securities regulators in pursuit of discovering every and all responsible for the fraudulent scheme inclusive of whichmembers of the aforementioned UNIVERSAL POPULACE™ in Chile participated in booking, classifying, categorizing, adjusting, altering, revising, changing, charging, billing, collecting, producing, composing, conducting, proofing, filtering, pressing, publishing, cataloging, indexing, posting, compressing, releasing, playing, displaying, broadcasting, distributing and/or syndicating transmission, rebroadcasting, redistributing and/or resyndicating transmission false and misleading information comprehensively suitable, generally pertinent and broadly useful to the enterprise holding company potential proposal to increase its stakeholders control of the holding company of national sovereign non-government bank by another +25%. The aforementioned PUBLIC FINANCIALS™ instruments of the holding company of national sovereign non-government bank surged nearly +12% after the false broadcast announcement was disemminated to the public via news agencies which further promulgated the phony and fraudulent announcement. The increased in the per share value of the aforementioned PUBLIC FINANCIALS™ instruments of the holding company of national sovereign Chile's securities regulators reported the enterprise holding company request for permission to potentially purchase an additional +5% percent of its business ownership position in the holding company of national sovereign non-government bank, a percentage increase which is a far-stretch from the +25% increase stated in the false, phony and hoax letter involving this fraudulent scheme which inadvertently found its way into the public domain. Further evidentiary every and all real-time processing and/or reprocessing of data and/or information receiver invovling false, phony and hoax oriented fraudulent announcements is evinced by a reported allegation reported within an article published in the Miami Herald dated Mar. 1, 2001, wherein it is referenced that a widely recognized and well-established public organization, the so-called U.S.'s largest income tax preparer, has been accused and fined by a so-called U.S. federal district court judge for deliberately and maliciously engaging in utilizing fraudulent and deceptive advertising initiatives, schemes, ocurrences, happenings, interactions, processes, methods, practices, movements, proceedings, messaging, presentations, notifications, filings, submissions, records, activities, actions, events, endeavors, tasks and affairs, inclusive of, without limitation, bad faith acts for having previously been sanctioned by state regulators subsequent to an earlier consumer protection agency complaint against the public organization's engaging in these forms of fraudulent and deceptive advertising initiatives, schemes, ocurrences, happenings, interactions, processes, methods, practices, movements, proceedings, messaging, presentations, notifications, filings, submissions, records, activities, actions, events, endeavors tasks and affairs. Apparently, the widely recognized and well-established public organization deliberately and maliciously engaging in utilizing fraudulent and deceptive advertising initiatives, schemes, ocurrences, happenings, interactions, processes, methods, practices, movements, proceedings, messaging, presentations, notifications, filings, submissions, records, activities, actions, events, endeavors, tasks and affairs which were intended to draw members of the aforementioned UNIVERSAL POPULACE™ away from an upstart competitior which had recently launched similar business initiatives, schemes, ocurrences, happenings, interactions, processes, methods, practices, movements, proceedings, messaging, presentations, notifications, filings, submissions, records, well-established largest tax preparer, who evidently falsely advertised continuous offerings to provide inappropriate and inefficient so-called early anticipation tax refunds inclusive of every and all inappropriate and inefficient so-called tax refunds to individual members of the aforementioned UNIVERSAL POPULACE™ without disclosing the terms and provisions of the loan products involved, inclusive of, without limitation, every and all pertinent fees, charges and interest rates assumed by members of the aforementioned UNIVERSAL POPULACE™ who unknowingly under the guise of good faith practices of the widely recognized and well-established public orgzatiotn requested these forms of tax preparer services which evidentily were driven exclusively by the false and misleading enticement of an early tax anticipation refund payment from the widely recognized and well-established public organization, To further reaffirm the inefficient, ineffective, dysfunctional and fragmented structural foundation and transactional exchange initiatives, schemes, ocurrences, happenings, interactions, processes, methods, practices, movements, proceedings, messaging, presentations, notifications, filings, submissions, records, activities, actions, events, endeavors, tasks and affairs which promulgate increases in the systematic volatility and the cost of capital with aforementioned fragmenting capital market inefficiencies it is clearly an undeniable and evidentiary findings of fact, documented reasoning and logical scientific deduction reasoning that aforementioned PUBLIC FINANCIALS™ instruments purchase and sale oriented lending rules, allow every and all members of the aforementioned UNIVERSAL POPULACE™ with very limited amounts of currency and/or other forms of liquid assets to readily borrow currency and credit purchasing power applicable to effectuating further purchase and sale oriented transactions inaforementioned PUBLIC FINANCIALS™ instruments as a function of the underlying valuation of their portfolios. Via the present lending rules and regulations which are hereto discovered prevelant with aforementioned fragmenting capital market inefficiencies, every and all members of the aforementioned UNIVERSAL POPULACE™ are able to borrow as much as fifty-percent of the underlying value of their portfolios to further purchase and/or sale oriented aforementioned PUBLIC FINANCIALS™ instruments which they logically cannot afford to be subject to over-bearing amounts of systematic volatility and certainly do not balances with NYSE and NASD member broker-dealers and/or banking and insurance related members of the aforementioned UNIVERSAL POPULACE™. It is an evidentiary findings of fact, documented reference, logical scientific deduction and intuitive analytical reasoning notwithstanding, every and all NYSE and NASD member broker-dealers, inclusive of, without limitation, banking and insurance related members of the aforementioned UNIVERSAL POPULACE™ and their subsidiaries are heretofore allowed and more than willing to subject these members of the aforementioned UNIVERSAL POPULACE™ to over-bearing amounts of risk because of the greed oriented interests pertaining to earning profit driven income and commissions for the NYSE and NASD member broker-dealers, banking or insurance related sales account executives. Evidently, these forms of unacceptable and predatory sales and commissioned practices parasitically feed off of every and all continued and perpetual harming, damaging, inuring, insistent, insinuating, imposing, pestilent, impetuous, importune, pestiferous, condescending and insolent enthralling, hindering, entrapping, pretending, miring, fatiguing, maleficience, harassing, engulfing, pressing, malevolent, presuming, imprinting, malicious, suffocating, miring, strangling, repressing, entangling, pestering and oppressing individual members of the aforementioned UNIVERSAL POPULACE™ which are traditionally concretizing via inefficient, ineffective, dysfunctional and fragmented vast networks of antiquated, archaic, ancient history and superannuated aforementioned PUBLIC FINANCIALS™ organizations which heretofore continuously, arrogantly, imprudently, irrationally and irresponsibly engage in propagating aforementioned fragmenting capital market inefficiencies via the communicating conduits of conceptual aids within a single holistically econometric marketplace environment. Furthermore, these forms of debt leverage on the ledger account balances which impose undeniable, unnecessary, undeniable, unnecessary, unwarranted, illogical, unjustifiable, unreasoned and unmitigated, illogical, unjustifiable and unreasoned and excessive borrowing capacity on the capacity work against protecting, sustaining and expanding the treasure accounting, financial fueling and econometric energizing members of the aforementioned UNIVERSAL POPULACE™ and promulgate undeniable, unnecessary, undeniable, unnecessary, unwarranted, aforementioned fragmenting capital market inefficiencies by triggering frantic, frenzied, freaking, frightened and/or spooked panic striken transactional oriented buying and selling among the logical participants aforementioned fragmenting capital market inefficiencies, which are further promulgated via continued and perpetual harming, damaging, inuring, insistent, insinuating, imposing, pestilent, impetuous, importune, pestiferous, condescending and insolent enthralling, hindering, entrapping, pretending, miring, fatiguing, maleficience, harassing, engulfing, pressing, malevolent, presuming, imprinting, malicious, suffocating, miring, strangling, repressing, entangling, pestering and oppressing individual members of the aforementioned UNIVERSAL POPULACE™ which are traditionally concretizing via inefficient, ineffective, dysfunctional and fragmented vast networks of antiquated, archaic, ancient history and superannuated aforementioned PUBLIC FINANCIALS™ organizations which heretofore continuously, arrogantly, imprudently, irrationally and irresponsibly engage in propagating aforementioned fragmenting capital market inefficiencies via the communicating conduits of conceptual aids within a single holistically econometric marketplace environment. Whereas, it is an undeniable and evidentiary findings of fact, documented reference, logical scientific reasoning and intuitive analytical reasoning that every and all of the aforementioned further involve, concern and pertain to every and all unsuitable rules and present regulations regarding margin borrowing debt leverage in our aforementioned fragmenting capital market inefficiencies, directly and indirectly, leads to systemic defaults, bankruptcy, systematic volatility and increases in the costs of capital involving aforementioned PUBLIC FINANCIALS™ instruments transactional exchange initiatives, schemes, ocurrences, happenings, interactions, processes, methods, practices, movements, proceedings, messaging, presentations, notifications, filings, submissions, records, activities, actions, events, endeavors, tasks and affairs. It is also noted that every and all exchange members, underwriters, broker/dealers, futures commodity merchants, commodity pool agents, commodity pool operators, quotation, clearance, execution, clearing and exchange oriented members of the aforementioned UNIVERSAL POPULACE™, trading specialists, specialist trading post market makers, retail private bankers, and related account executives which are predominately commission oriented and their subsidiaries promulgate these continous forms of frantic, frenzied, freaking, frightened and/or spooked panic striken transactional oriented buying and selling with aforementioned fragmenting capital market inefficiencies. These undeniable, unnecessary, undeniable, unnecessary, unwarranted, illogical, unjustifiable, unreasoned and unmitigated, illogical, unjustifiable and unreasoned frantic, frenzied, freaking, frightened and/or spooked panic striken transactional oriented buying and selling are evindent in the systematic volatility trading patterns and trends displayed as a function of the price quotations and exchange valuaitons of individual securities registered, listed and exchanged with aforementioned fragmenting capital market inefficiencies and under the guise offering members of the aforementioned UNIVERSAL POPULACE™ prudent, sound and research oriented advisory and transactional exchange services every and all intermediary banking, securities and insurance oriented members of the aforementioned UNIVERSAL POPULACE™ and their subsidiaries are completely acting against serving the best interests members of the aforementioned UNIVERSAL POPULACE™ in promulgating every and all such initiatives, schemes, ocurrences, happenings, interactions, processes, methods, practices, movements, proceedings, messaging, presentations, notifications, filings, submissions, records, activities, actions, events, endeavors, tasks and affairs effectuated by sales and commission oriented banking, securities and insurance related members of the aforementiond UNIVERSAL POPULACE™ and their subsidiaires continue to imposition of their exclusive historical and present enthrallment over aforementioned fragmenting capital market inefficiencies by preventing enhanced fairness, simulteanoues equality, full transparency, consolidated access and perpetual integration to every and all techniques, designs, systems, routines, devices, manners, modes, fashions, forms, formats, factors, objects, parts, segments, elements, components, constituents, ingredients, processes, methods and combinations pertaining to streamlined, alternating scale, inseparable, seamless and natural wrapping, interlacing, coiling, coupling, combining and interlocking aforementioned PUBLIC FINANCIALS™ statements inclusive of seamlessly and naturally wrapped, twisted, mixed, convoluted, embroidered and combined in connection with aforementioned PUBLIC FINANCIALS™ instruments from members of the aforementioned aforementioned PUBLIC FINANCIALS™ instruments transactional exchange data with aforementioned PUBLIC FINANCIALS™ instruments transactional exchange information. lit is clearly an undeniable and evidentiary findings of fact, documented reference, logical scientific deduction and intuitive analytical reasoning that that overwhelming majority of banking, securities and insurance related transactional interchanage and excahnge initiatives, schemes, ocurrences, happenings, interactions, processes, methods, practices, movements, proceedings, messaging, presentations, notifications, filings, submissions, records, activities, actions, events, endeavors, tasks and affairs effectuated by sales and commission driven banking, securities and insurance related members of the aforementioned UNIVERSAL POPULACE™ present continue to promulgate their evident historical and traditioanl enthrallment over aforementioned fragmenting capital market inefficiencies inclusive of, without limitation, every and all members of the aforementioned UNIVERSAL POPULACE™ pursue allocating a position of leverage and competitive advantage in the global marketplace by promulgating false and misleading commercial incoherent advertisements, financial publications, radio broadcasts, specialty magazines articles, inclusive of every and all techniques, designs, systems, routines, devices, manners, modes, fashions, forms, formats, factors, objects, parts, segments, elements, components, constituents, ingredients, processes, methods and combinations of dissemination to members of the aforementioned UNIVERSAL POPULACE™ wherein these members of the aforementioned UNIVERSAL POPULACE™ are misled into believing that one or another banking, securities and insurance related public organization inclusive of, without limitation, it subsidiary branches and sales commissioned account executives have a strong hold over a competitive advantage, strategic position or highly exclusive research every and all real-time processing and/or reprocessing of data and/or information receiver which can afford them an advantage over another with aforementioned fragmenting capital market inefficiencies in pursuit of access to wealth via aforementioned PUBLIC FINANCIALS™ instruments. These false and misleading commercial incoherent advertisements, financial publications, radio broadcasts, specialty magazines articles should be found liable under every and all deceptive advertisement and unfair trade intuitive analytical reasoning that no one person or organization hereto has access to real-time public financial statement and PUBLIC FINANCIALS™ instruments concerning any one or a number members of the aforementioned UNIVERSAL POPULACE™ or real-time aforementioned PUBLIC FINANCIALS™ instruments aforementioned PUBLIC FINANCIALS™ instruments data and aforementioned PUBLIC FINANCIALS™ instruments aforementioned PUBLIC FINANCIALS™ instruments non-financial information concerning transactional exchange initiatives, schemes, ocurrences, happenings, interactions, processes, methods, practices, movements, proceedings, messaging, presentations, notifications, filings, submissions, records, activities, actions, events, endeavors, tasks and affairs with aforementioned fragmenting capital market inefficiencies. Ifany one or another banking, securities and insurance related members of the aforementioned UNIVERSAL POPULACE™ and their subsidiaries do obtain every and all public financial statement and PUBLIC FINANCIALS™ instruments concerning any one or a number members of the aforementioned UNIVERSAL POPULACE™ or real-time aforementioned PUBLIC FINANCIALS™ instruments aforementioned PUBLIC FINANCIALS™ instruments data and aforementioned PUBLIC FINANCIALS™ instruments aforementioned PUBLIC FINANCIALS™ instruments non-financial information which would offer them a competitive advantage, strategic position or highly exclusive research every and all real-time processing and/or reprocessing of data and/or information receiver not available to othermembers of the aforementioned UNIVERSAL POPULACE™ or members of the aforementioned UNIVERSAL POPULACE™ with aforementioned fragmenting capital market inefficiencies and they attempting to utilize every and all forms, parts, means and segements pertaining to that every and all real-time processing and/or reprocessing of data and/or information receiver for their own profit and/or for the benefit of the ledger account balances of their members of the aforementioned UNIVERSAL POPULACE™ they would immediately and logically be in violation of the selective information prohibitions via the so-called U.S. SEC's recently enacted Regulation Fair Disclosure, inclusive of, without limitation, every and all rules and regulations pertaining to insider trading prohibitions enacted as legal precedent via so-Therefore, it is clearly an undeniable and evidentiary findings of fact, documented reference, logical scientific deduction and intuitive analytical reasoning that every and all false and misleading commercial incoherent advertisements, financial publications, radio broadcasts, specialty magazines articles, inclusive of every and all techniques, designs, systems, routines, devices, manners, modes, fashions, forms, formats, factors, objects, parts, segments, elements, components, constituents, ingredients, processes, methods and combinations of dissemination of inappropriate, imprudent, potentially illegal marketing, touting purporting, boasting and claiming to members of the aforementioned UNIVERSAL POPULACE™ are misled to believing that one banking, securities and insurance related organization and their subsidiary oreinted sales commissioned account accoutives display a competitive advantage, strategic position or highly exclusive research every and all real-time processing and/or reprocessing of data and/or information receiver which can afford them an advantage over another with aforementioned fragmenting capital market inefficiencies. Every and all of these techniques, designs, systems, routines, devices, manners, modes, fashions, forms, formats, factors, objects, parts, segments, elements, components, constituents, ingredients, processes, methods and combinations of false and misleading commercial incoherent advertisements, financial publications, radio broadcasts, specialty magazines articles, inclusive of every and all techniques, designs, systems, routines, devices, manners, modes, fashions, forms, formats, factors, objects, parts, segments, elements, components, constituents, ingredients, processes, methods and combinations of dissemination of inappropriate, imprudent, potentially illegal marketing, touting, purporting, boasting and claiming competitive advantage, strategic position or highly exclusive research every and all real-time processing and/or reprocessing of data and/or information receiver over another public organization in the global marketplace is completely false, illogical and adamantly should be considered illegal initiatives, schemes, ocurrences, happenings, interactions, processes, methods, practices, movements, proceedings, messaging, presentations, notifications, filings, submissions, records, activities, actions, events, endeavors, tasks and affairs by the independent regulatory authorities which would include, without limitation, every and all of the General Office; so-called US. Department of Treasury so-called U S. Office of Thrift and Comptroller of the Currency; so-called U.S. Postal Service; so-called U.S. Customs Service; so-called U.S. State Attorney General Offices; so-called U.S. State Securities Administrators Offices; so-called U.S. State Insurance Administors Offices; so-called U.S. State Child and Family Services Offices; so-called U.S. State Welfare and Employment Assistance Services Offices; so-called U.S. Department of Education; so-called U.S. State Offices of Educational Assistance; so-called U.S. Small Business Administration Offices; so-called U.S. Federal Trade Commission; so-called Office of Management and Budget; so-called Government Accounting Office; so-called Congressional Budget Office; so-called U.S. Immigration and Naturalization Service; so-called U.S. Public Service Commission; so-called U.S. Federal Communications Commission; the so-called U.S. Federal Bureau of Investigation; so-called National Security Agency; so-called National Aeronautical Space Administration; so-called U.S. Central Intelligency Agency; so-called U.S. Agency of Alcohol Tobacco and Firearms; World Trade Organization; Congress of Industrial Organizations; World Intellectual Property Organization; Organization for Economic Cooperation and Development; Organization of America States; World Bank; International Monetary Fund; United Nations; Warring International Crimes Tribunal and every and all hereafter existent applicable hereto members of the aforementioned UNIVERSAL POPULACE™ agencies and other governing and regulatory hereto members of the aforementioned UNIVERSAL POPULACE™ bodies should work together in multilaterial and multi-capacity initiatives, schemes, ocurrences, happenings, interactions, processes, methods, practices, movements, proceedings, messaging, presentations, notifications, filings, submissions, records, activities, actions, events, endeavors, tasks and affairs to stop and prevent every and all banking, securities and insurance related members of the aforementioned UNIVERSAL POPULACE™ and their subsidiary oriented sales commissioned account executives from preying on unsophisticated members of the aforementioned UNIVERSAL POPULACE™. Whereas, it is an undeniable and evidentiary findings of fact, documented reference, logical scientific deduction and intuitive analytical reasoning that the largest majority therein live paycheck-to-paycheck just to make ends meet, and happenings, interactions, processes, methods, practices, movements, proceedings, messaging, presentations, notifications, filings, submissions, records, activities, actions, events, endeavors, tasks and affairs and savings are heretofore continuously preyed upon by the vast network of intermediary banking, securities and insurance related members of the aforementioned UNIVERSAL POPULACE™ and their subsidiary sales commissioned account executives which heretofore enthrall members of the aforementioned UNIVERSAL POPULACE™ with heretofore aforementioned fragmenting capital market inefficiencies. It is ironic that every and all of these many unsophisticated members of the aforementioned UNIVERSAL POPULACE™ are sold diverse products and services which replicate baskets of narrow or broad-based aggregate composite indexes and derivative oriented indices which incorrectly are in the ancient history and present inefficient, ineffective, dysfunctional and aforementioned fragmenting capital market inefficiencies considered the ulimate window display the actual quotations and capitalizations involving the underlying aforementioned PUBLIC FINANCIALS™ instruments members of the aforementioned UNIVERSAL POPULACE™ or therefrom derivative oriented PUBLIC FINANCIALS™ instruments, and irrespective of what happens to the quotations and valuations aforementioned PUBLIC FINANCIALS™ instruments the vast intermediary network of banking, securities and insurance related members of the aforementioned UNIVERSAL POPULACE™ and their subsidiaries are continuously charged undeniable, unnecessary, unwarranted, illogical, unjustifiable, unreasoned and unmitigated spreads on transactional exchange inclusive of, imposing undeniable, unnecessary, unwarranted, illogical, unjustifiable, unreasoned and unmitigated commission and sales oriented charges to seamlessly and naturally aforementioned PUBLIC FINANCIALS™ instruments transactional exchange initiatives, schemes, ocurrences, happenings, interactions, processes, methods, practices, movements, proceedings, messaging, presentations, notifications, filings, submissions, records, activities, actions, events, endeavors, tasks and affairs withwith aforementioned fragmenting capital market inefficiencies. Moreover, it is even more ironic that excessive asset management fees, surcharges and sales commissions are charged and/or imposed on members of the aforementioned US$350 billion a year present assumed by members of the aforementioned UNIVERSAL POPULACE™ to seamlessly and naturally transactional exchanges regarding their portfolios of which heretofore every and all are enthralled by the need to utilize these vast networks of intermediary aforementioned PUBLIC FINANCIALS™ organizations and their sales driven and commission income earning staff personnel employees to seamlessly and naturally banking, securities and insurance related transactional exchange under inappropriate artifical and excessive fees, charges, sur-charges, clearning fees, exchange fees, and sales commissions inclusive of, without limitation, advertising, distribution, and operating management fees every and all of which promulgate the very false and misleading commercial incoherent advertisements, financial publications, radio broadcasts, specialty magazines articles, inclusive of every and all techniques, designs, systems, routines, devices, manners, modes, fashions, forms, formats, factors, objects, parts, segments, elements, components, constituents, ingredients, processes, methods and combinations of false and misleading statemetns which promulgate beliefs that one or another banking, securities and insurance related public organization and its subisidiary branches copious works in their best interests and thereupon comprises a competitive advantage, strategic position and/or highly exclusive research every and all real-time processing and/or reprocessing of data and/or information receiver which they are afford to members of the aforementioned UNIVERSAL POPULACE™ in direct contrast to some other banking, securities and insurance related public organization with aforementioned fragmenting capital market inefficiencies. Whereas, it is an undeniable and evidentiary findings of fact, documented reference, logical scientific deduction and intuitive analytical reasoning that every and all such guised statements continuously disseminated in the public domain by banking, securities and insurance related members of the aforementioned UNIVERSAL POPULACE™ simply further exemplify in every and all techniques, designs, systems, routines, devices, manners, modes, fashions, forms, formats, factors, objects, parts, segments, elements, components, constituents, ingredients, processes, methods and combinations inappropriate, unsubstantiated and unsuitable promulgation of continued and perpetual harming, damaging, inuring, insistent, insinuating, imposing, pestilent, impetuous, importune, pestiferous, imprinting, malicious, suffocating, miring, strangling, repressing, entangling, pestering and oppressing individual members of the aforementioned UNIVERSAL POPULACE™ which are traditionally concretizing via inefficient, ineffective, dysfunctional and fragmented vast networks of antiquated, archaic, ancient history and superannuated aforementioned PUBLIC FINANCIALS™ organizations which heretofore continuously, arrogantly, imprudently, irrationally and irresponsibly engage in propagating aforementioned fragmenting capital market inefficiencies via the communicating conduits of conceptual aids within a single holistically econometric marketplace environment. Whereas, it is an undeniable and evidentiary findings of fact, documented reference, logical scientific reasoning and intuitive analytical reasoning that every and all of the aforementioned further involve, concern and pertain to every and all techniques, designs, systems, routines, devices, manners, modes, fashions, forms, formats, factors, objects, parts, segments, elements, components, constituents, ingredients, processes, methods and combinations aforementioned PUBLIC FINANCIALS™ statements seamlessly and naturally wrapped, twisted, mixed, convoluted, embroidered and combined in connection with aforementioned PUBLIC FINANCIALS™ instruments from members of the aforementioned UNIVERSAL POPULACE™ inclusive of, without limitation, aforementioned PUBLIC FINANCIALS™ instruments transactional exchange data with aforementioned PUBLIC FINANCIALS™ instruments transactional exchange information with aforementioned fragmenting capital market inefficiencies in the public domain. It is herein clearly and evidentiary findings of fact, documented reference, logical scientific deduction reasoning that the structural foundation of the aforementioned fragmenting capital market inefficiencies, as they exist in present techniques, designs, systems, routines, devices, manners, modes, fashions, forms, formats, factors, objects, parts, segments, elements, components, constituents, ingredients, processes, methods and combinations is and are severely limited in the information technology foundation, structure, architecture and capacity to meet the unmet informaiton content management, financial services and aforementioned PUBLIC FINANCIALS™ instruments transactional exchange initiatives, schemes, ocurrences, happenings, interactions, processes, methods, practices, movements, proceedings, messaging, presentations, and dated technologies, and are thereupon present are completely failing in, and potentially obtrusively acting out a guised and falsely touted, marketed, purported and bolstered, ability to serve in a fiduciary capacity on behalf of tens of thousands members of the aforementioned UNIVERSAL POPULACE™ and hundreds of millions members of the aforementioned UNIVERSAL POPULACE™ which may inevitably reside in every and all national sovereign borders of every and all of the industrialized, developed and developing economies throughout the world when it is extremely clear that they are evidently, respectively, independently, autonomously, evidently, undeniably, logically, scientifically and intuitively incapable and unable to serve in any such techniques, designs, systems, routines, devices, manners, modes, fashions, forms, formats, factors, objects, parts, segments, elements, components, constituents, ingredients, processes, methods and combinations in the present inefficient, dysfuctional, fragmented and disintegrated UNIVERSAL CAPITAL MARKET™, which further evinces that there is a tremendously long-held and enormously heart-felt need in the relevant art for innovative panacean cutting-edge technologically panacean cutting-edge innovative developments and technological advancements to ensure that full disclosure, best practices, best executions, enhanced fairness, simultaneous equality, full transparency, consolidated access and perpetual integration of members members of the aforementioned UNIVERSAL POPULACE™ in incorporation any all basic functional elements and integral transactional activite which encompass and comprise every and all of the distinctively separate and traditionally exclusive specialty areas public accounting, transport reconciling, independent auditing and financial reporting inclusive of order-entry quotation, matching, clearance, execution, settlement and exchange of insurance, risk financing, credit, cash management, investment banking and aforementioned PUBLIC FINANCIALS™ instruments within the aforementioned fragmenting capital market inefficiencies are expediently conceived, engineered, designed and developed via constructive reduction to practice and somehow herewith this legal patent application document find their way to the forefront of the global marketplace for the benefit of tens of thousands members of the aforementioned UNIVERSAL POPULACE™ and hundreds of millions members of the aforementioned UNIVERSAL POPULACE™ who pestiferous, condescending and insolent enthralling, hindering, entrapping, pretending, miring, fatiguing, maleficience, harassing, engulfing, pressing, malevolent, presuming, imprinting, malicious, suffocating, miring, strangling, repressing, entangling, pestering and oppressing via the UNIVERSAL CAPITAL MARKET™ inefficiencies and vast network of exclusive intermediary members of the aforementioned UNIVERSAL POPULACE™ which heretofore serve with unfair trade and predatory intentions within the aforementioned fragmenting capital market inefficiencies. Furthermore, it is an evidentiary findings of fact, documented reference, logical scientific deduction and intuitive analytical reasoning which evinces existence of a tremendously long-held and enormously heart-felt need in the relevant art which is further promulgated by the tactics of banking, securities, and insurance oriented holding companies, theirmembers of the aforementioned UNIVERSAL POPULACE™ and their inherently aggressively driven and strictly commission income earning staff personnel employees who flagrantly and actively lure, bait and entice members of the aforementioned UNIVERSAL POPULACE™ with aforementioned fragmenting capital market inefficiencies into frantic, frenzied, freaking, frightened and/or spooked panic striken transactional oriented buying and selling with extensive utilization of deceitful and predatory practices which involve use of abusive manipulations marked by impudent statements to acquire every and all techniques, designs, systems, routines, devices, manners, modes, fashions, forms, formats, factors, objects, parts, segments, elements, components, constituents, ingredients, processes, methods and combinations of obscure authority from unsophisticated, unwilling and unknowing members of the aforementioned UNIVERSAL POPULACE™ to seamlessly and naturally commission income driven transactional exchange initiatives, schemes, ocurrences, happenings, interactions, processes, methods, practices, movements, proceedings, messaging, presentations, notifications, filings, submissions, records, activities, actions, events, endeavors, tasks and affairs which inevitably leads to every and all techniques, designs, systems, routines, devices, manners, modes, fashions, forms, formats, factors, objects, parts, segments, elements, components, constituents, ingredients, processes, methods and combinations of overwhelming, undeniable, unnecessary, unwarranted, illogical, unjustifiable, unreasoned and evidently, logically and scienfically deduced as being exclusively assumed and incurred by members of the aforementioned UNIVERSAL POPULACE™ within the aforementioned fragmenting capital market inefficiencies and the present inefficient, dysfunctional, fragmented and distintegrated W.W. capital markets. Moreover, its is an undeniable and evidentiary findings of fact, documented reference, logical scientific deduction and intuitive analytical reasoning that the tremendously long-held and enormously heart-felt need in the relevant art pleads calls for innovative and technologically panacean cutting-edge innovative developments and technological advancements createe via innovative panacean cutting-edge technologically panacean cutting-edge innovative developments and technological advancements which can ensure that full disclosure, best practices, best executions, enhanced fairness, simultaneous equality, full transparency, consolidated access and perpetual integration of members members of the aforementioned UNIVERSAL POPULACE™ in every and all basic elemental developments, necessary interactions and integral transactional exchange initiatives, schemes, ocurrences, happenings, interactions, processes, methods, practices, movements, proceedings, messaging, presentations, notifications, filings, submissions, records, activities, actions, events, endeavors, tasks and affairs by seamlessly and naturally streamlined, alternating scale, inseparable, seamless and natural wrapping, interlacing, coiling, coupling, combining and interlocking every and all techniques, designs, systems, routines, devices, manners, modes, fashions, forms, formats, factors, objects, parts, segments, elements, components, constituents, ingredients, processes, methods and combinations of the distinctively separate and traditionally exclusive specialty areas of public accounting, transport reconciling, independent auditing and financial reporting via seamlessly and naturally streamlined, alternating scale, inseparable, seamless and natural wrapping, interlacing, colling, coupling, combining and interlocking every and all techniques, designs, systems, routines, devices, manners, modes, fashions, forms, formats, factors, objects, parts, segments, elements, components, constituents, ingredients, processes, methods and combinations with the distinctively separate and traditionally exclusive specialty areas order-entry quotation, matching, clearance, execution, settlement and exchange of insurance, risk financing, credit, cash is an undeniable and evidentiary findings of fact, documented reference, logical scientific deduction and intuitive analytical reasoning which evinces that the vast network of banking, securities and insurance oriented members of the aforementioned UNIVERSAL POPULACE™, their subsidiary branch oriented public organization and their commission driven staff personnel employees present offer varying techniques, designs, systems, routines, devices, manners, modes, fashions, forms, formats, factors, objects, parts, segments, elements, components, constituents, ingredients, processes, methods and combinations of access aforementioned PUBLIC FINANCIALS™ instruments transactional exchange initiatives, schemes, ocurrences, happenings, interactions, processes, methods, practices, movements, proceedings, messaging, presentations, notifications, filings, submissions, records, activities, actions, events, endeavors, tasks and affairs by utilizing archaic methodologies rudimentary processes, and dated technologies, and therefore are heretofore completely failing in their fiduciary capacity to serve the unmet every and all real-time processing and/or reprocessing of data and/or information receiver content management, financial services and public UNIVERSAL CAPITAL MARKET™ securiteis aforementioned PUBLIC FINANCIALS™ instruments transactional so-called U.S. Securities Exchange Act of 1934ivitiy needs of tens of thousands members of the aforementioned UNIVERSAL POPULACE™ and hundreds of millions members of the aforementioned UNIVERSAL POPULACES residing in every and all sovereign industrialized, developed, and developing nations throughout the world. Furthermore, the recent expansion of derivative oriented aforementioned PUBLIC FINANCIALS™ instruments which have present surpassed transactional exchange volumes in the underlying currency, stock equity and debt bond oriented aforementioned PUBLIC FINANCIALS™ instruments themselves further evinces the inherent exposure to potential increase in the systematic volaility and increase in the costs of capital prevalent with aforementioned fragmenting capital market inefficiencies and therewithal completely assumed, directly and indirectly, by tens of hundreds of thousands members of the aforementioned UNIVERSAL POPULACE™ and hundreds of millions members of the aforementioned UNIVERSAL POPULACE™ residing in every and all sovereign industrialized, developed, and developing nations aforementioned fragmenting capital market inefficiencies which evidently displays the patterns and trends of an innately dynamic and higly volatile global marketplace that as it pertains to stock equity aggregate composite indexes are comprehensively suitable, generally pertinent and broadly useful to the aforementioned fragmenting capital market inefficiencies, it is editorial investigators from the so-called Wall Street Journal, a division of the Dow Jones Co., Inc. which identify and select the members of the aforementioned UNIVERSAL POPULACE™ which are invited to join the DJIA NYSE Composite Index. Ironically, the DJIA-NYSE Composite Index which is present the world's most widely accepted and recognized stock equity indictor of the that expectations, anticipations, hopes, wishes, desires, concerns, uncertainties and fears members of the aforementioned UNIVERSAL POPULACE™ are comprehensively suitable, generally pertinent and broadly useful to the market capitalization of the aforementioned PUBLIC FINANCIALS™ instruments members of the aforementioned UNIVERSAL POPULACE™ which directly and indirectly are logical participants with aforementioned fragmenting capital market inefficiencies, and which thereupon members of the aforementioned UNIVERSAL POPULACE™ from around the world are heretofore falsely misled into a preconcevied notion that this limited and editorial selected list members of the aforementioned UNIVERSAL POPULACE™ is the timely, accurate, reliable and verifiable meter of the transactional exchange initiatives, schemes, ocurrences, happenings, interactions, processes, methods, practices, movements, proceedings, messaging, presentations, notifications, filings, submissions, records, activities, actions, events, endeavors, tasks and affairs, and treasure accounting, financial fueling and econometric energizing of the so-called U.S. and therefrom a timely, accurate, reliable and verifiable meter of the transactional exchange initiatives, schemes, ocurrences, happenings, interactions, processes, methods, practices, movements, proceedings, messaging, presentations, notifications, filings, submissions, records, activities, actions, events, endeavors, tasks and affairs, and treasure accounting, financial fueling and econometric energizing of every and all sovereign foreign industrialized, developed and developing nations from around a single holistically econometric marketplace environment. With all due respect to the financial publication of the and all persons and/or entities contracted and/or employed as partners and/or free-lance personnel thereto are in no form, part, method and/or segment capable of any such comparison to elite world-class leaders and industry professionals with experience, innovation, creativity, experimentation, imagination, knowledge, skills, talents and abilities who serve as either owners and/or directors, and further may be employed by members of the aforementioned UNIVERSAL POPULACE™ which inevitably participate with aforementioned fragmenting capital market inefficiencies, and therewithal devote their time, energy and the economic and financial resources of theirmembers of the aforementioned UNIVERSAL POPULACE™ to promulgate every and all techniques, designs, systems, routines, devices, manners, modes, fashions, forms, formats, factors, objects, parts, segments, elements, components, constituents, ingredients, processes, methods and combinations of public organizational transactional exchange initiatives, schemes, ocurrences, happenings, interactions, processes, methods, practices, movements, proceedings, messaging, presentations, notifications, filings, submissions, records, activities, actions, events, endeavors, tasks and affairs among industries and sectors of the aforementioned efficient UNIVERSAL ECONOMY™ which promulgates products, goods, supplies and services which transcend the sovereign economies of the industrialized, developing and developed economies from around the world nor does the present NYSE-DJIA composite index serve in every and all limited techniques, designs, systems, routines, devices, manners, modes, fashions, forms, formats, factors, objects, parts, segments, elements, components, constituents, ingredients, processes, methods and combinations as an accurate, timely, reliable and verifiable meter of transactional exchange initiatives, schemes, ocurrences, happenings, interactions, processes, methods, practices, movements, proceedings, messaging, presentations, notifications, filings, submissions, records, activities, actions, events, endeavors, tasks and affairs and expectations, anticipations, hopes, wishes, desires, concerns, uncertainties and fears of senior executives of public organization who have their fingers on the pulse of the so-called U.S. economic and W.W. economic transactional exchange initiatives which logically transcend the industrialized, developing and developed nations from around the world, and thus can effectively gauge the treasure intuitively integrated UNIVERSAL ECONOMY™. Moreover, the falsely misled preconceived notions which heretofore exist in the minds members of the aforementioned UNIVERSAL POPULACE™ are comprehensively suitable, generally pertinent and broadly useful to the market capitalization of the aforementioned PUBLIC FINANCIALS™ instruments members of the aforementioned UNIVERSAL POPULACE™ which logically participate with aforementioned fragmenting capital market inefficiencies due to the focus on the NYSE-DJIA or the NASDAQ composite indices further continues the enthrallment of the vast network of intermediary banking, securities and insurance oriented members of the aforementioned UNIVERSAL POPULACE™ and the subsidiary branches propagating and promulgate continued and perpetual harming, damaging, inuring, insistent, insinuating, imposing, pestilent, impetuous, importune, pestiferous, condescending and insolent enthralling, hindering, entrapping, pretending, miring, fatiguing, maleficience, harassing, engulfing, pressing, malevolent, presuming, imprinting, malicious, suffocating, miring, strangling, repressing, entangling, pestering and oppressing individual members of the aforementioned UNIVERSAL POPULACE™ which are traditionally concretizing via inefficient, ineffective, dysfunctional and fragmented vast networks of antiquated, archaic, ancient history and superannuated aforementioned PUBLIC FINANCIALS™ organizations which heretofore continuously, arrogantly, imprudently, irrationally and irresponsibly engage in propagating aforementioned fragmenting capital market inefficiencies via the communicating conduits of conceptual aids within a single holistically econometric marketplace environment, Whereas, it is an undeniable and evidentiary findings of fact, documented reference, logical scientific reasoning and intuitive analytical reasoning that every and all of the aforementioned further involve, concern and pertain to every and all techniques, designs, systems, routines, devices, manners, modes, fashions, forms, formats, factors, objects, parts, segments, elements, components, constituents, ingredients, processes, methods and combinations aforementioned PUBLIC FINANCIALS™ statements seamlessly and naturally wrapped, twisted, mixed, convoluted, embroidered and combined in connection with aforementioned PUBLIC FINANCIALS™ instruments from members of the aforementioned UNIVERSAL FINANCIALS™ instruments transactional exchange non-financial, which further leads to tempestuous exponentially detrimental increases in the systematic volatility and tempestuous exponentially debilitating increases in the cost of capital evinced in the ancient history and present inefficient, ineffective, dysfunctional and aforementioned fragmenting capital market inefficiencies. The recent display of exponential aforementioned PUBLIC FINANCIALS™ instruments tempestuous devaluation evinces the tremendously long-held and enormously heart-felt unmet needs in the relevant art for innovative panacean cutting-edge resarch developments and technological advancements which concretize techniques, designs, systems, routines, devices, manners, modes, fashions, forms, formats, factors, objects, parts, segments, elements, components, constituents, ingredients, processes, methods and combinations of compositions which intrinsically and integrally evince innovative groundbreaking and breakthrough utility engineering and architectural design propagations of long-term formation and establishement of new and higher standards to actualize an aforementioned efficient UNIVERSAL CAPITAL MARKET™ which as a function of the tremendously long-held and enormously heart-felt needs in the relevant art inclusive of, without limitation, the heretofore tempestuous detrimental increases in systematic volatility and tempestuous exponentially debilitating increases in the cost of capital offer sufficient evidence that every and all of the heretofore distinctively separate and traditionally exclusive so-called skilled practicioners in the relevant art have not felt it necessary to recognize nor address to actively and passionately pursue an ease of use unequivocal absolute resolution.

8. Public Capital Market Insurance

It is herein noted that insurance related members of the aforementioned UNIVERSAL POPULACE™ are intrinsically involved in the act, business or systems of protecting or coverering members of the aforementioned UNIVERSAL POPULACE™ and clients, customers, consumers, member-subscribers, constituents, creditors, shareholders, stakeholders, so-called U.S. depositors, so-called U.S. citizen taxpayers, foreign national depositors, foreign national taxpayers, members of the aforementioned UNIVERSAL compensation to individual members of the aforementioned UNIVERSAL POPULACE™. The mere potential of suffering damage, loss and/or injury in both qualitative forms and quantitative terms of which said potential suffering and/or incurring damage, loss and/or injury cannot conceivably be known in advance but which must in every and all techniques, designs, systems, routines, devices, manners, modes, fashions, forms, formats, factors, objects, parts, segments, elements, components, constituents, ingredients, processes, methods and combinations be concretizing as an act or occurance during the specific time period of the formal and legally binding contract period serves as the primary reasoning for transportring the financial related risk associated with every and all unknown factors, things, elements or courses of initiatives, schemes, ocurrences, happenings, interactions, processes, methods, practices, movements, proceedings, messaging, presentations, notifications, filings, submissions, records, activities, actions, events, endeavors, tasks and affairs. Historically, insurance related members of the aforementioned UNIVERSAL POPULACE™ have served as the primary techniques, designs, systems, routines, devices, manners, modes, fashions, forms, formats, factors, objects, parts, segments, elements, components, constituents, ingredients, processes, methods and combinations which assumed this implied volatility or actuarially assumed facial risks members of the aforementioned UNIVERSAL POPULACE™ and individual consumers not being capable of predetermining the acts and occurences inclusive of, without limitation, the dangers and probabilities associated with suffering damage, loss and/or injury as they respectively go about living their day-to-day lives in today's civilized society, Interestingly, insurance related members of the aforementioned UNIVERSAL POPULACE™ are not engaged in the commercial business of assuming the risk transportred to them from every and all counter-party and/or Third Party members of the aforementioned UNIVERSAL POPULACE™ or clients, customers, consumers, member-subscribers, constituents, creditors, shareholders, stakeholders, so-called U.S. depositors, so-called U.S. citizen taxpayers, foreign national depositors, foreign national taxpayers, members of the aforementioned UNIVERSAL POPULACE™ so that upon actualization of every and all such acts and occurances the counter-party and/or Third Party members of the aforementioned UNIVERSAL POPULACE™ or depositors, foreign national taxpayers, members of the aforementioned UNIVERSAL POPULACE™ are fully restored to their perceived values as of the date enactment of the formal and legally binding contract agreement. Rather, historically and present the commercial business of heretofore actuarially assuming financial risk transportred to them from every and all counter-party and/or Third Party members of the aforementioned UNIVERSAL POPULACE™ or clients, customers, consumers, member-subscribers, constituents, creditors, shareholders, stakeholders, so-called U.S. depositors, so-called U.S. citizen taxpayers, foreign national depositors, foreign national taxpayers, members of the aforementioned UNIVERSAL POPULACE™ upon the actualization of acts and occurences which are confirmed and verified in the forms of damage, loss and/or injury to offer a limited amount of the aformentioned efficient UNIVERSAL CAPITAL MARKET™ security oriented and financial related compensatory reimbursement for having incurred every and all techniques, designs, systems, routines, devices, manners, modes, fashions, forms, formats, factors, objects, parts, segments, elements, components, constituents, ingredients, processes, methods and combinations of damage, loss and/or injury assuming that said acts and occurences included said damage, loss and/or injury under the specified factors, things, elements and/or courses of initiatives, schemes, ocurrences, happenings, interactions, processes, methods, practices, movements, proceedings, messaging, presentations, notifications, filings, submissions, records, activities, actions, events, endeavors, tasks and affairs protected or converted, and which thereupon not specifically excluded, under the formal and legally binding contract agreement between the insurance related public organization and a counter-party and/or Third Party members of the aforementioned UNIVERSAL POPULACE™ or clients, customers, consumers, member-subscribers, constituents, creditors, shareholders, stakeholders, so-called U.S. depositors, so-called U.S. citizen taxpayers, foreign national depositors, foreign national taxpayers, members of the aforementioned UNIVERSAL POPULACE™. It is here noted that every and all techniques, designs, systems, routines, devices, manners, modes, fashions, forms, formats, factors, objects, parts, segments, elements, components, constituents, ingredients, processes, methods and combinations of the aformentioned efficient UNIVERSAL CAPITAL MARKET™ security restore the counter-party and/or Third Party members of the aforementioned UNIVERSAL POPULACE™ or clients, customers, consumers, member-subscribers, constituents, creditors, shareholders, stakeholders, so-called U.S. depositors, so-called U.S. citizen taxpayers, foreign national depositors, foreign national taxpayers, members of the aforementioned UNIVERSAL POPULACE™ against the financial risk associated with said specific acts or occurences which may or may not be concretizing during the time period in which such protect or coverage via indemnification legally binds the insurance related public organization to make compensatory reimbursement. Thus, insurance related public organization are involved in the commercial business initiatives, schemes, ocurrences, happenings, interactions, processes, methods, practices, movements, proceedings, messaging, presentations, notifications, filings, submissions, records, activities, actions, events, endeavors, tasks and affairs of engaging in actuarially assuming specified quantitative financial risk in exchange for a predetermined rate and/or risk premium associated with the potential unknown or unforeseen specified factors, things, elements and/or courses of initiatives, schemes, ocurrences, happenings, interactions, processes, methods, practices, movements, proceedings, messaging, presentations, notifications, filings, submissions, records, activities, actions, events, endeavors, tasks and affairs which may or may not concretize and/or occur to the counter-party public organization or clients, customers, consumers, member-subscribers, constituents, creditors, shareholders, stakeholders, so-called U.S. depositors, so-called U.S. citizen taxpayers, foreign national depositors, foreign national taxpayers, members of the aforementioned UNIVERSAL POPULACE™ during the specified time period of the formal and legally binding contract for a profit. In order to predetermine the quantitative actuarialy assumed financial risk associated with a counter-party and/or Third Party public organizaation or clients, customers, consumers, member-subscribers, constituents, creditors, shareholders, stakeholders, so-called U.S. depositors, so-called U.S. citizen taxpayers, foreign national depositors, foreign national taxpayers, members of the aforementioned UNIVERSAL POPULACE™ potentially suffering damage, loss and/or injury to specified life, health, property, casualty, liabilities, valuables and/or factors, things, elements and/or courses of initiatives, schemes, ocurrences, happenings, endeavors, tasks and affairs the risk assuming insurance related public organization engages in conducting extensive statistically based techniques, designs systems, routines devices, manners, modes, fashions, forms, formats, factors, objects, parts, segments, elements, components, constituents, ingredients, processes, methods and combinations of actuarial analysis. It is herein noted that every and all forms, parts, means and segment of actuarially assumed financial risk may pertain to property and casualty or life, health and annuity oriented for-profit commercial business insurance related initiatives, schemes, ocurrences, happenings, interactions, processes, methods, practices, movements, proceedings, messaging, presentations, notifications, filings, submissions, records, activities, actions, events, endeavors, tasks and affairs, and in this regard every and all of the following may be protected or covered under claims made or occurrence based insurance policies and/or contracts concerning insurance, reinsurance and alternative risk management of said counter-party and/or Third Party public organization or clients, customers, consumers, member-subscribers, constituents, creditors, shareholders, stakeholders, so-called U.S. depositors, so-called U.S. citizen taxpayers, foreign national depositors, foreign national taxpayers, members of the aforementioned UNIVERSAL POPULACE™ whom may potentially incur every and all techniques, designs, systems, routines, devices, manners, modes, fashions, forms, formats, factors, objects, parts, segments, elements, components, constituents, ingredients, processes, methods and combinations of damage, loss and/or injury to life, health, property, casualty, liabilities, valuables and/or factors, things, elements and/or courses of initiatives, schemes, ocurrences, happenings, interactions, processes, methods, practices, movements, proceedings, messaging, presentations, notifications, filings, submissions, records, activities, actions, events, endeavors, tasks and affairs which involve every and all catastrophes, perils, infrequent risks, variable risks and pure risks, inclusive of, without limitation, personal and/or group fife, death, accidential death, dismembermemt, disability, personal estate, taxable estate, major medical, prescription, dental, vision, annuity, property, hurricane, windstorm, earthquake, typhoon, flood, thunderstorm, avalanche, mudslide, general liability, automobile liability, automobile collision, automobile damage, automobile rental, general casualty, directors and officers, aviation, real and personal property, assessment, renters', boiler and machinery, business interruption, systematic volatility, cost of capital, letters of credit, account recivables, account payables, internal auditing, external auditing, legal trial and appellate costs, legal trial and appellate expense, legal trial and appellate contingency, mediation, arbitration, assets, liabilities, personal income taxation, personal capital gains taxation, corporate income taxation, corporate capital gains taxation, personal and/or corporate bankruptcy, personal and/or commercial real and intangible tax assessment, intangible goodwill, intellectual property patent, intellectual property trademark, intellectual property copyrights intellectual property trade secrets, intellectual property unfair competition, breach and/or threatened breach and/or infringement whether or not deliberate, unintential, malicious, predatory and/or knowingly or unknowingly of every and all aforementioned intellectual property, residual equities, errors and ommissions, professsional liability, course of construction, open carge, port operators, charter legal, inland transit, value of goods plus prepaid freight, continuous, warehouse to warehouse, ocean or transnational transit, certificates not required, quarterly financial and non-finacial reporting, annual financial and non-financial reporting, inclusive of, without limitation, subset techniques, designs, systems, routines, devices, manners, modes, fashions, forms, formats, factors, objects, parts, segments, elements, components, constituents, ingredients, processes, methods and combinations concering other political, transnational, marine, bodily injury and property damage, products, contractural, employee benefits, employee dishonesty, loss of currency, loss of securities, personal injury, advertising injury, non-owned aircraft, airport operator's, aircraft products, ionizing star ship transport articles; aircraft maintenance, personal, corporate reimbursement, sudden and accidental pollution, employment practices, cost allocation, contracted work general liability, workers' compensation, defamation of charter, defamation of property, marine property, broad all-risk, terrorism, kidnapping, every and all forms of transit, medical and security emergency response, travelers, medical evaluations, annual subscription/pay for use, owner controller, currency inconvertibility, expropriation, war, nationalization, all of which, without limitation, may involve general, excess, frequent, umbrella, stop-loss, stop-gap, prepaid, financing, premiums maintenance, may or may not involve exclusions, endorsements, riders and/or addendums related to every and all of the above referenced. Moreover, it is clearly an undeniable and evidentiary findings of fact, documented reference, logical scientific deduction and intuitive analytical reasoning that actuarial analysis is every and all techniques, designs, systems, routines, devices, manners, modes, fashions, forms, formats, factors, objects, parts, segments, elements, components, constituents, ingredients, processes, methods and combinations the intrinsic premise upon which for-profit commercial business insurance related initiatives, schemes, ocurrences, happenings, interactions, processes, methods, practices, movements, proceedings, messaging, presentations, notifications, filings, submissions, records, activities, actions, events, endeavors, tasks and airs are engaged, and further which applies specifically to every and all actuarially based statistical inferences or assignment of probabistic percentages involivng every and all UNIVERSAL CAPITAL MARKET™ security oriented monetary compensatory indemnification or reimbursement associated with the potential unknown or unforeseen specified factors, things, elements and/or courses of initiatives, schemes, ocurrences, happenings, interactions, processes, methods, practices, movements, proceedings, messaging, presentations, notifications, filings, submissions, records, activities, actions, events, endeavors, tasks and affairs which may or may not concretize and/or occur to the counter-party and/or Third Party public organization or clients, customers, consumers, member-subscribers, constituents, creditors, shareholders, stakeholders, so-called U.S. depositors, so-called U.S. citizen taxpayers, foreign national depositors, foreign national taxpayers, members of the aforementioned UNIVERSAL POPULACE™ which may or may not concretize and/or occur during the specified time period of the formal and legally binding contract agreement between the insuring party and the counter-party and/or Third Party, and thus entails in every and all techniques, designs, systems, routines, devices, manners, modes, fashions, forms, formats, factors, objects, parts, segments, elements, components, constituents, ingredients, processes, methods and combinations the methods of predetermining the rate and/or risk premium which the insurance related public organization arbitrarily charges members of the aforementioned UNIVERSAL POPULACE™ or clients, customers, consumers, member-subscribers, of the aforementioned UNIVERSAL POPULACE™ counter-parties and/or third-parties for assuming or accepting said transport of financial risk in quantitative terms associated with the potential actualization or occurance of damage, loss and/or injury which may or may not entail, encompass, comprise, involve, impact and/or effect life, health, property, casualty, liabilities, valuables and/or factors, things, elements and/or courses of initiatives, schemes, ocurrences, happenings, interactions, processes, methods, practices, movements, proceedings, messaging, presentations, notifications, filings, submissions, records, activities, actions, events, endeavors, tasks and affairs. It is also an undeniable and evidentiary findings of fact, documented reference, logical scientific deduction and intuitive analytical reasoning that in the so-called U.S. insurance related members of the aforementioned UNIVERSAL POPULACE™ are required to apply with state regulatory agencies to receive a certificate of authority prior to legally engage in every and all techniques, designs, systems, routines, devices, manners, modes, fashions, forms, formats, factors, objects, parts, segments, elements, components, constituents, ingredients, processes, methods and combinations involving so-called actuarially underwriting or more appropriately actuarially assuming or accepting every and all said transport of financial risk in quantitative terms associated with the potential actualization or occurance of damage, loss and/or injury which may or may not entail, encompass, comprise, involve, impact and/or effect life, health, property, casualty, liabilities, valuables and/or factors, things, elements and/or courses of initiatives, schemes, ocurrences, happenings, interactions, processes, methods, practices, movements, proceedings, messaging, presentations, notifications, filings, submissions, records, activities, actions, events, endeavors, tasks and affairs to offer in exchange for and entailing every and all techniques, designs, systems, routines, devices, manners, modes, fashions, forms, formats, factors, objects, parts, segments, elements, components, constituents, ingredients, processes, methods and combinations the methods of a predetermined rate and/or risk premium which the insurance related public organization arbitrarily charges members of the aforementioned UNIVERSAL POPULACE™ or clients, customers, consumers, member-subscribers, constituents, creditors, shareholders, stakeholders, so-called U.S. depositors, so-called U.S. citizen taxpayers, foreign national related compensatory reimbursement for potentially incurring every and all techniques, designs, systems, routines, devices, manners, modes, fashions, forms, formats, factors, objects, parts, segments, elements, components, constituents, ingredients, processes, methods and combinations of damage, loss and/or injury to life, health, property, casualty, liabilities, valuables and/or factors, things, elements and/or courses of initiatives, schemes, ocurrences, happenings, interactions, processes, methods, practices, movements, proceedings, messaging, presentations, notifications, filings, submissions, records, activities, actions, events, endeavors, tasks and affairs assuming that said acts and occurences included said damage, loss and/or injury under the specified factors, things, elements and/or courses of initiatives, schemes, ocurrences, happenings, interactions, processes, methods, practices, movements, proceedings, messaging, presentations, notifications, filings, submissions, records, activities, actions, events, endeavors, tasks and affairs protected or converted, and which thereupon not specifically excluded, under the formal and legally binding contract agreement between the insurance related public organization and a counter-party and/or Third Party members of the aforementioned UNIVERSAL POPULACE™ or clients, customers, consumers, member-subscribers, constituents, creditors, shareholders, stakeholders, so-called U.S. depositors, so-called U.S. citizen taxpayers, foreign national depositors, foreign national taxpayers, members of the aforementioned UNIVERSAL POPULACE™ limited UNIVERSAL CAPITAL MARKET™ security oriented monetary compensatory indemnification or reimbursement associated with the potential of unknown or unforeseen potential suffering and/or incurring damage, loss and/or injury which may or may not concretize and/or occur during the specified time period of the formal and legally binding contract agreement between the insuring party and the counter-party and/or Third Party. Moreover, irrespective of whether or not said protection or coverage offered by the insurance related public organization whether or not in limited techniques, designs, systems, routines, devices, manners, modes, fashions, forms, formats, factors, objects, parts, segments, elements, components, constituents, ingredients, processes, methods and combinations pertaining to stop-loss and/or stop-gap arrangements of risk assumption, every and all is and/or are still a function of engagement in the involvement of a counter-shareholders, stakeholders, so-called U.S. depositors, so-called U.S. citizen taxpayers, foreign national depositors, foreign national taxpayers, members of the aforementioned UNIVERSAL POPULACE™ making and/or maintaining predetermined rate and/or risk premium payments in every and all techniques, designs, systems, routines, devices, manners, modes, fashions, forms, formats, factors, objects, parts, segments, elements, components, constituents, ingredients, processes, methods and combinations for which the insurance related pubic organization arbitrarily charges members of the aforementioned UNIVERSAL POPULACE™ or clients, customers, consumers, member-subscribers, constituents, creditors, shareholders, stakeholders, so-called U.S. depositors, so-called U.S. citizen taxpayers, foreign national depositors, foreign national taxpayers, members of the aforementioned UNIVERSAL POPULACE™ counter-parties and/or third-parties for assumming or accepting said transport of financial risk in quantitative terms associated with the potential actulization or occurance of every and all unknown or unforeseen potential suffering and/or incurring damage, loss and/or injury to life, health, property, casualty, liabilities, valuables and/or factors, things, elements and/or courses of initiatives, schemes, ocurrences, happenings, interactions, processes, methods, practices, movements, proceedings, messaging, presentations, notifications, filings, submissions, records, activities, actions, events, endeavors, tasks and affairs, and which under the law are only restored and/or remedied in civilized society via via financial related compensatory reimbursement is and/or are simply transactional exchange oriented commercial business initiatives, schemes, ocurrences, happenings, interactions, processes, methods, practices, movements, proceedings, messaging, presentations, notifications, filings, submissions, records, activities, actions, events, endeavors, tasks and affairs which in no technique designs, systems, routines, devices, manners, modes, fashions, forms, formats, factors, objects, parts, segments, elements, components, constituents, ingredients, processes, methods and combinations are unlike every and all other banking and securities oriented members of the aforementioned UNIVERSAL POPULACE™ transactional exchange oriented commercial commercial business initiatives, schemes, ocurrences, happenings, interactions, processes, methods, practices, movements, proceedings, messaging, presentations, notifications, filings, submissions, dysfunctional and aforementioned fragmenting capital market inefficiencies. To further grasp an entire conceptualization, clear recognition and full apprecitiaon of the historical and present role of insurance related members of the aforementioned UNIVERSAL POPULACE™ inclusive of; risk management oriented reinsurance companies and syndicated securitization of transportred techniques, designs, systems, routines, devices, manners, modes, fashions, forms, formats, factors, objects, parts, segments, elements, components, constituents, ingredients, processes, methods and combinations of unknown and unforeseen potential damage, loss and/or injury to specified life, health, property, casualty, liabilities, valuables and/or factors, things, elements and/or courses of initiatives, schemes, ocurrences, happenings, interactions, processes, methods, practices, movements, proceedings, messaging, presentations, notifications, filings, submissions, records, activities, actions, events, endeavors, tasks and affairs members of the aforementioned UNIVERSAL POPULACE™ within the aforementioned efficient UNIVERSAL ECONOMY™ of the global marketplacement environment, it is necessary to undestand and define the concepts of insurance and reinsurance, and further study and analyze the formation of one of a single holistically econometric marketplace environment's most widely recognized and well-established insuranre and reinsurance underwriting syndicates of products and services related large unconventional approaches to risk management namely the organization referred to as Society of Lloyd's of London. As noted herein, insurance is a protection or coverage, for a specified period of time and under specified terms and provisions, against the potential damages, losses and/or injuries of to specified life, health, property, casualty, liabilities, valuables and/or factors, things, elements and/or courses of initiatives, schemes, ocurrences, happenings, interactions, processes, methods, practices, movements, proceedings, messaging, presentations, notifications, filings, submissions, records, activities, actions, events, endeavors, tasks and affairs members of the aforementioned UNIVERSAL POPULACE™ within the aforementioned efficient UNIVERSAL ECONOMY™ of the global marketplacement environment, wherein the transport of financial transactional exchange risk is assumed by the insurance related public organization in exchange for an arbitrarily charged and predetermined rate and/or risk premium payment which the counter-party and/or Third insurance related organization is arrived at from the art and science of statistically inferring to the population at large from the historical data, information, trends of patterns of damages, losses and/or injuries concretizing or occurred by members of the aforementioned UNIVERSAL POPULACE™. In order to entirely conceptualize, clearly recognize and fully appreciate that in respect to the distinctively separate and traditionally exclusive techniques, designs, systems, routines, devices, manners, modes, fashions, forms, formats, factors, objects, parts, segments, elements, components, constituents, ingredients, processes, methods and combinations of insurance policies pertaining to property and casualty acts and occurences and life, health and annuity acts and occurences, further distinction pertaining to confirming and verifying declarations and claims thereto can be structured under a claims made and occurences basis. The heretofore major distinction between a claims made and occurences basis are quite separate and impact the techniques, designs, systems, routines, devices, manners, modes, fashions, forms, formats, factors, objects, parts, segments, elements, components, constituents, ingredients, processes, methods and combinations of handling and administering these declarations and claims which may evince damages, losses and/or injuries pertaining to insurance, reinsurance and alternative risk management financing mechanisms. Under the notion of a claims made basis insurance policy the statistical inferences or assignment of probabistic percentages involivng every and all UNIVERSAL CAPITAL MARKET™ security oriented monetary compensatory indemnification or reimbursement associated with the potential unknown or unforeseen specified factors, things, elements and/or courses of initiatives, schemes, ocurrences, happenings, interactions, processes, methods, practices, movements, proceedings, messaging, presentations, notifications, filings, submissions, records, activities, actions, events, endeavors, tasks and affairs which may or may not concretize and/or occur to the counter-party public organization or clients, customers, consumers, member-subscribers, constituents, creditors, shareholders, stakeholders, so-called U.S. depositors, so-called U.S. citizen taxpayers, foreign national depositors, foreign national taxpayers, members of the aforementioned UNIVERSAL POPULACE™ which may concretize and/or occur during the specified time period of the formal and legally binding contract agreement which said potential unknown and unforeseen acts and/or occurrences come to fruition, otherwise if declared and/or claimed in subsequent periods of time, whether or not continuing protection or coverage is secured, would be denied every and all techniques, designs, systems, routines, devices, manners, modes, fashions, forms, formats, factors, objects, parts, segments, elements, components, constituents, ingredients, processes, methods and combinations of the aformentioned efficient UNIVERSAL CAPITAL MARKET™ security oriented monetary compensatory indemnification or reimbursement. Under the notion of an occurrence basis insurance policy the statistical inferences or assignment of probabistic percentages involivng every and all UNIVERSAL CAPITAL MARKET™ security oriented monetary compensatory indemnification or reimbursement associated with the potential unknown or unforeseen specified factors, things, elements and/or courses of initiatives, schemes, ocurrences, happenings, interactions, processes, methods, practices, movements, proceedings, messaging, presentations, notifications, filings, submissions, records, activities, actions, events, endeavors, tasks and affairs which may or may not concretize and/or occur to the counter-party public organization or clients, customers, consumers, member-subscribers, constituents, creditors, shareholders, stakeholders, so-called U.S. depositors, so-called U.S. citizen taxpayers, foreign national depositors, foreign national taxpayers, members of the aforementioned UNIVERSAL POPULACE™ which may concretize and/or occur during the specified time period of the formal and legally binding contract agreement between the insuring party and the counter-party and/or Third Partyacts or occurences of, potential damages, loss and/or injury may be declared and/or claimed subsequent to the year in which said potential unknown and unforeseen acts and/or occurrences came to fruition whether or not said acts and/or occurences declarations and/or claims are made in subsequent periods of time, and whether or not continuing protection or coverage is secured, wherein the insuring party could not deny every and all techniques, designs, systems, routines, devices, manners, modes, fashions, forms, formats, factors, objects, parts, segments, elements, components, constituents, ingredients, processes, methods and combinations of the aformentioned efficient UNIVERSAL CAPITAL MARKET™ security oriented monetary compensatory indemnification or reimbursement would be forms, formats, factors, objects, parts, segments, elements, components, constituents, ingredients, processes, methods and combinations of insurance protection or coverage becomes clearer when associated and cognitively recognized as it pertaining to life, health and annuity acts and/or occurences which lead to future declarations and/or claims. When an act or occurence is evinced there may not be an immediate akcnowledgement of said unknown and unforeseen damage, loss and/or injury because a significant period of may elapse before the damage, loss and/or injury is concretizing and acknowledged by the insured party or a counter-party and/or Third Party, and therefore under these potential scenarios it would be inconsistent with protection or coverage to preclude every and all techniques, designs, systems, routines, devices, manners, modes, fashions, forms, formats, factors, objects, parts, segments, elements, components, constituents, ingredients, processes, methods and combinations of future declarations and/or claims which may only be concretizing and come to fruition via declarations and/or claims in subsequent years from the specified period of time in which the damage, loss and/or injury actually took place. This is often the case in pollution related protection or coverage wherein it would be impossible to predict if said pollution oriented policies may or may not evince health-related declarations and/or claims in periods of time subsequent to the period in which the pollution acts and/or occurences may have caused initial damage, loss and/or injury to a counter-party and/or Third Party. Thereupon, one would expect that pollution oriented insurance policies may or may not evince fixture declarations and/or claims pertaining to protection or coverage during a specific period of time, but therewithal would remain potential outstanding liabilities for decades of time subsequent to the actual year in which a predetermined rate and/or risk premium was paid to an insurance related organization for a specific protection or coverage for a specific period of time pertaining to potential pollution related acts or occurences which cause and/or lead to future damage, loss and/or injuries related to specified life, health, property, casualty, liabilities, valuables and/or factors, things, elements and/or courses of initiatives, schemes, ocurrences, happenings, interactions, processes, methods, practices, movements, proceedings, messaging, presentations, notifications, filings, submissions, records, activities, actions, events, endeavors, tasks and affairs members of the the idea and concept of reinsurance is more applicable to the actualization of occurrence of necessity which requisites further transports of the actuarial assumed financial risk from an insurance related public organization to a syndicate of member organizations involved in accepting the transport of a percentage of the potential damages, losses and/or injuries of to specified life, health, property, casualty, liabilities, valuables and/or factors, things, elements and/or courses of initiatives, schemes, ocurrences, happenings, interactions, processes, methods, practices, movements, proceedings, messaging, presentations, notifications, filings, submissions, records, activities, actions, events, endeavors, tasks and affairs members of the aforementioned UNIVERSAL POPULACE™ within the aforementioned efficient UNIVERSAL ECONOMY™ of the global marketplacement environment, wherein the transport of financial transactional exchange risk is assumed by the reinsurance related public organization in exchange for a portion of the arbitrarily charged and predetermined rate and/or risk premium payment which the counter-party and/or Third Party agrees to make and/or maintain over the specified period of time of the protection or coverage offered and provided by the insurance related organization. Therewithal, reinsurance related members of the aforementioned UNIVERSAL POPULACE™ are strictly involved in risk management initiatives, schemes, ocurrences, happenings, interactions, processes, methods, practices, movements, proceedings, messaging, presentations, notifications, filings, submissions, records, activities, actions, events, endeavors, tasks and affairs to further allow them to protect, sustain and expand their treasure accounting, financial fueling and econometric energizing of the underlying insurance related members of the aforementioned UNIVERSAL POPULACE™. Therein, reinsurance related public organization do not directly interact and/or provide insurance protection or coverage on the potential damages, losses and/or injuries of to specified life, health, property, casualty, liabilities, valuables and/or factors, things, elements and/or courses of initiatives, schemes, ocurrences, happenings, interactions, processes, methods, practices, movements, proceedings, messaging, presentations, notifications, filings, submissions, records, activities, actions, events, endeavors, tasks and affairs members of the aforementioned UNIVERSAL POPULACE™ within the aforementioned efficient UNIVERSAL portion of the arbitrarily charged and predetermined rate and/or risk premium payment which the counter-party and/or Third Party agrees to make and/or maintain over the specified period of time of the protection or coverage offered and provided by the insurance related organization, and the reinsurance liability for the portion of the financial transactional exchange risk is only effective and requited over and above the damages, losses and/or injuries that are concretizing or occur to specified life, health, property, casualty, liabilities, valuables and/or factors, things, elements and/or courses of initiatives, schemes, ocurrences, happenings, interactions, processes, methods, practices, movements, proceedings, messaging, presentations, notifications, filings, submissions, records, activities, actions, events, endeavors, tasks and affairs members of the aforementioned UNIVERSAL POPULACE™ within the aforementioned efficient UNIVERSAL ECONOMY™ of the global marketplacement environment, wherein said reinsurance liability involves every and all UNIVERSAL CAPITAL MARKET™ security oriented and financial related compensatory reimbursement which exceeds the stop-loss gap layer of financial transactional exchange risk assumed by the insurance related public organizaiton subsequent to the initial deductible value of assumed damages, losses and/or injuries of the counter-party and/or Third Party. Essentially, it becomes an undeniable finding of fact, documented reference, logical scientific deduction reasoning to acknowledge that no one insurance related public organization can assume the potential UNIVERSAL CAPITAL MARKET™ security oriented and financial related compensatory reimbursement which may arise from unknown and unforeseen the damages, losses and/or injuries that are concretizing or occur to specified life, health, property, casualty, liabilities, valuables and/or factors, things, elements and/or courses of initiatives, schemes, ocurrences, happenings, interactions, processes, methods, practices, movements, proceedings, messaging, presentations, notifications, filings, submissions, records, activities, actions, events, endeavors, tasks and affairs members of the aforementioned UNIVERSAL POPULACE™ within the aforementioned efficient UNIVERSAL ECONOMY™ of the global marketplacement environment, therefore a portion of the arbitrarily charged and predetermined rate and/or risk premium payment which the counter-party and/or Third Party agrees to make and/or maintain over the unforeseen the damages, losses and/or injuries over and above a predetermined monetary limit which is assumed by the insurance related public organization, and is a so-called stop-loss limit. The idea and concept which drives insurance and reinsurance, and alternative risk management is that no one public organization displays the operating, financial and transactional exchange capacity, liquidity or operational capabilities to assume all of the potential damages, losses and/or injuries from unknown and unforeseen acts or occurences which may or may not be confirmed and verified protection or coverage during the specified period of time and under specified terms and provisions of the insurance contract agreement executed between the insurance related public organization and a counter-party and/or Third Party members of the aforementioned UNIVERSAL POPULACE™;, of which said potential damages, losses and/or injuries may become readily apparent and/or readily quantifiable either during and/or subsequent to the time period of protection or coverage. Thus, the premise of the concept of insurance is to spread the actuarially assumed financial transactional exchange risk of any one counter-party and/or Third Party members of the aforementioned UNIVERSAL POPULACE™ over a large group of homogeneous insured pertaining to the same specified terms and provisions of the insurance contract agreement executed between the insurance related public organization and a counter-party and/or Third Party members of the aforementioned UNIVERSAL POPULACE™, inclusive of, without limitation, the specified time period of the insurance contract agreement. To further conceptualize the level of risk management which occurs behind the scenes but which nevertheless involved, directly and/or indirectly, the protection or coverage inclusive of, without limitation, the exchanged predetermined rate and/or risk premium which members of the aforementioned UNIVERSAL POPULACE™ within the aforementioned efficient UNIVERSAL ECONOMY™ of the global marketplacement environment continuously incur to go about their day-to-day lives with more security are comprehensively suitable, generally pertinent and broadly useful to their expectations, anticipations, hopes, wishes, desires, concerns, uncertainties and fears of the unknown and unforeseen future it is important to understand the history and structure of the most widely recognized and well-established reinsurance organization in the world which is often referred to as the Society Department of Trade and Industry that regulates the insurance industry in the United Kingdom, which provides the umbrella transactional exchange name under which reinsurance transactional exchange is effectuated as commercial business initiatives, schemes ocurrences, happenings, interactions, processes, methods, practices, movements, proceedings, messaging, presentations, notifications, filings, submissions, records, activities, actions, events, endeavors, tasks and affairs. The Society of Lloyd's of London consists of a varying number of wealthy individuals and as of 1994members of the aforementioned UNIVERSAL POPULACE™ that are involved in actuarially assuming financial transactional exchange risk involving the transport of every and all techniques, designs, systems, routines, devices, manners, modes, fashions, forms, formats, factors, objects, parts, segments, elements, components, constituents, ingredients, processes, methods and combinations of unknown and unforeseen potential damage, loss and/or injury to specified life, health, property, casualty, liabilities, valuables and/or factors, things, elements and/or courses of initiatives, schemes, ocurrences, happenings, interactions, processes, methods, practices, movements, proceedings, messaging, presentations, notifications, filings, submissions, records, activities, actions, events, endeavors, tasks and affairs members of the aforementioned UNIVERSAL POPULACE™ within the aforementioned efficient UNIVERSAL ECONOMY™ of the global marketplacement environment, no matter haw odd, irregular or bizarre the techniques, designs, systems, routines, devices, manners, modes, fashions, forms, formats, factors, objects, parts, segments, elements, components, constituents, ingredients, processes, methods and combinations of financial risk transactional exchange seem and/or appear. In contrast to prudent risk management pertaining to the potential damage, loss and/or injury to specified life, health, property, casualty, liabilities, valuables and/or factors, things, elements and/or courses of initiatives, schemes, ocurrences, happenings, interactions, processes, methods, practices, movements, proceedings, messaging, presentations, notifications, filings, submissions, records, activities, actions, events, endeavors, tasks and affairs members of the aforementioned UNIVERSAL POPULACE™ within the aforementioned efficient UNIVERSAL ECONOMY™ of the global marketplacement environment, the Society of Lloyd's of affecting insurance policies outstanding were known to have occurred and were fully costed by the time loss receipts and/or profit payments were made to the syndicate members of the Society of Lloyd's of London. It is an evidentiary findings of fact, documented reference, logical scientific deduction reasoning that the outstanding liability of wealth members is limited only by the extent of their personal wealth, wherein as of 1994members of the aforementioned UNIVERSAL POPULACE™ participating in the Society are enabled to have outstanding liabilities limited only by the value of their assets, and present in every and all cases the liability of Society members is limited to and related separately to each party to an specified actuarially assumed financial transactional exchange risk therein further defined as a indefinite but small number of Society members. The Society of Lloyd's of London wealthy individual membership syndicate participation arranges for a Member Agent to authorize the actuarially assumed financial transactional exchange risk wherein the Society of Lloyd's of London public organization membership syndicate participation arranges for a Lloyd's Advisor or members Agents to authorize the actuarially assumed financial transactional exchange risk are comprehensively suitable, generally pertinent and broadly useful to the potential damage, loss and/or injury to specified life, health, property, casualty, liabilities, valuables and/or factors, things, elements and/or courses of initiatives, schemes, ocurrences, happenings, interactions, processes, methods, practices, movements, proceedings, messaging, presentations, notifications, filings, submissions, records, activities, actions, events, endeavors, tasks and affairs members of the aforementioned UNIVERSAL POPULACE™ within the aforementioned efficient UNIVERSAL ECONOMY™ of the global marketplacement environment. The Society of Lloyd's of London validates membership syndicate participants abilities to demonstrate solvency and to pay losses by requiting assets to be deposited with the control of the Society of Lloyd's of Lond, and further by requiring members who wish to continue their membership syndicate participation to deposit assets or currency as necessary to meet solvency requirements and losses. Every and all active membership syndicate participation in the actuarial assumption of financial transactional exchange risk in the Society of Lloyd's of London requisites that every and all members' have made payment deduction and intuitive analytical reasoning that the Society of Lloyd's of London assumed significant financial transactional exchange setbacks from damages, losses and injuries decleared during the years of 1992-1998. The Society of Lloyd's of London time-lagged financial transactional exchange monetary setbacks became evident when in 1991 under its historical and present time-lagged a three year accounting system it became evident that claims and declarations dating back to 1998 were being addressed, wherein approximately £10 billion in U.K. equivalent pounds were indentified. It is a undeniable and evidentiary findings of fact, documented reference and logical deduced scientific reasoning that the generalization of these time-lagged monetary setbacks in financial transactional exchange risks actuarially assumed by the Society of Llyod's of London were predominately from two areas which involved the destnctively spiraling notion of insuring and reinsuring financial transactional exchange risks within the Society's of Lloyd's of Lond's own membership syndication participation circuits, and monetary setbacks which pertained to asbestors and pollution claims in the so-called U.S. and which further concerned incidential non-marine oriented exposures which had been insured by the Society membership syndicate participants decades before wherein it became increasingly difficult for the Society of Lloyd's of Lond to gauge the aim, letter, nature, breadth, sound, depth and scope of their potential monetary setbacks of financial transactional exchange risk from the policies written at earlier times. These significant monetary setbacks inevitably dimished the Society membership syndicate participants insuring capacity and led to a major reconstruction and renewal plan for the Society of Lloyd's of London which was approved by the UK government's Department of Trade and Industry Insurance Regulator, and led entry members of the aforementioned UNIVERSAL POPULACE™ to offer treasure accounting, financial fueling and econometric energizing. Three consequences to the Society of Lloyd's of London structural foundation from the monetary setbacks that were claims and declarations dating back to 1998, wherein there was evinced a drop in insuring capacity from £11.38 billion in UK pounds during 1988 to £9.85 billion in UK pounds as of 1996 as members of the Society voluntarily and involuntarily, ceased or reduced their actuarial assumption of financial transactional exchange risk, some years of assuming financial transactional for lack of support from other membership syndicates, and members formed into action groups in order to mount legal proceedings to recover their losses from the managing agents and manager agents, whose alleged negligence were deemed responsible for those monetary setbacks in financial transactional exchange risk by membership syndicate participants. It is an evidentiary findings of fact, documented reference, logical scientific deduction reasoning that these aforementioned consequences from the destrictively spiraling notion of insuring and reinsuring financial transactional exchange risks within the Society's of Lloyd's of Lond's own membership syndication participation circuits, and monetary setbacks which pertained to asbestors and pollution claims in the so-called U.S. affected the Society of Lloyd's of London expenses and therefore its competitiveness in the global marketplace envionrment for actuarially assuming financial transactional exchange risks from potential damage, loss and/or injury to specified life, health, property, casualty, liabilities, valuables and/or factors, things, elements and/or courses of initiatives, schemes, ocurrences, happenings, interactions, processes, methods, practices, movements, proceedings, messaging, presentations, notifications, filings, submissions, records, activities, actions, events, endeavors, tasks and affairs members of the aforementioned UNIVERSAL POPULACE™ within the aforementioned efficient UNIVERSAL ECONOMY™ of the global marketplacement environment. The Reconstruction and Renewal Plan was promulgated by the Society of Lloyd's of London as of May 1995 as a capacity of addressing the aforementioned consequences and to facilitate a method of re-establishing confidence in the Society of Lloyd's of London and its insuring capacity pertaining to the heretofore inefficient and ineffective actuarial assumptions premised on assuming financial transactional exchange risk, wherein a single remedy was pursued to address all of the consequences. The essential or central core of the Reconstruction and Renewal Plan for the Society of Lloyd's of London involved establishment of another reinsurance public organization which assumed for a reinsurance premium every and all of the liabilities of all policies outstanding from membership syndicate participants pertaining to actuarially assuming financial transactional exchange risks up to and including the year-ending 1992, wherein this separate reinsurance public organization insulates the year ending 1993 and every and all publicity, expense and distractions, every and all replication of reinsuring potential liabilities from outstanding policies have been eradicated because of centralization of every and all such outstanding policies from actuarial assumed financial transactional exchange risks up to and including the year-ending 1992 thereby reducing expenses to the Society of Lloyd's of London syndicates, whether litigating against managing agents and manager agents premised upon their alleged negligence pertaining to those monetary setbacks the Society of Lloyd's of London membership syndicate participants have been able to stop every and all future payment of losses pertaining to every and all years prior to 1993, and apart from recurring on-going litigation and claims are comprehensively suitable, generally pertinent and broadly useful to the years prior to 1992 the Society of Lloyd's of London has been therto been confidently and competitively capable of engaging in commercial business transactional exchange initiatives, schemes, ocurrences, happenings, interactions, processes, methods, practices, movements, proceedings, messaging, presentations, notifications, filings, submissions, records, activities, actions, events, endeavors, tasks and affairs are comprehensively suitable, generally pertinent and broadly useful to the actuarially assuming financial transactional exchange risk related to potential syndicated securitization of in every and all transactional exchange oriented transportred techniques, designs, systems, routines, devices, manners, modes, fashions, forms, formats, factors, objects, parts, segments, elements, components, constituents, ingredients, processes, methods and combinations of unknown and unforeseen potential damage, loss and/or injury to specified life, health property, casualty, liabilities valuables and/or factors, things, elements and/or courses of initiatives, schemes, ocurrences, happenings, interactions, processes, methods, practices, movements, proceedings, messaging, presentations, notifications, filings, submissions, records, activities, actions, events, endeavors, tasks and affairs members of the aforementioned UNIVERSAL POPULACE™ within the aforementioned efficient UNIVERSAL ECONOMY™ of the global marketplacement environment. It is noteworthy that between the years of 1991 to 1993 the global results of allocated insuring capacity and profitability are comprehensively suitable, generally pertinent and broadly useful to the Society of Lloyd's of London evinced respective insuring capacity and loss/profit worth of insuring capacity with a loss of £1.193 billion in U.K. pounds, while in 1993 it was £8.784 billion in U.K. pounds worth of insuring capacity with a profit of £225 million in U.K. pounds, thereupon evincing a relatively catastrophic-free 1993 in direct contrast to the high incidences of major catastrophes in previous years of which notable incidences involved Hurricane Andrew which impact the South Florida area of the so-called U.S., and London terrorist bombings which occurred in 1992. Moreover, now having an entire conceptualized, clearly recognized and fully appreciated understanding of the basic ideas, concepts and historical context of insurance and reinsurance commercial business oriented initiatives, schemes, ocurrences, happenings, interactions, processes, methods, practices, movements, proceedings, messaging, presentations, notifications, filings, submissions, records, activities, actions, events, endeavors, tasks and affairs, it is necessary to grasp an entirely conceptualized, clearly recognized and fully appreciated understanding of basic and alternative techniques, designs, systems, routines, devices, manners, modes, fashions, forms, formats, factors, objects, parts, segments, elements, components, constituents, ingredients, processes, methods and combinations risk management financing and the ideas and concepts inclusive of, without limitation, the benefits and costs they afford members of the aforementioned UNIVERSAL POPULACE™ involved in the so-called U.S. economy, so-called U.S. capital market, W.W. economies and W.W. capital markets. Therewith, the idea and concept of alternative techniques, designs, systems, routines, devices, manners, modes, fashions, forms, formats, factors, objects, parts, segments, elements, components, constituents, ingredients, processes, methods and combinations of insurance and reinsurance protection or coverage pertain to the specialty field of risk management and its financing mechanisms where protection or coverage is not available, protection or coverage is available at an extremely high price, protection or coverage is available but the public organization or personal consumer is in a high risk group with lower than average losses and the predetermined rate and/or risk premium does not properly reflect its experience, or the public organization of personal consumer believes the protection or coverage necessary can be offered at less than the predetermined rates and/or risk premium available in the insurance and reinsurance global marketplace. Whereas, it is an routines, devices, manners, modes, fashions, forms, formats, factors, objects, parts, segments, elements, components, constituents, ingredients, processes, methods and combinations of risk management and damage, loss and/or injury control involve every and all of exposure identification, risk analysis, risk financing, risk elimination, risk eduction, risk retention, risk transport, management operations, declaration and claims handling, administration, governance, wherein the purpose or kernal of forming, managing and implementing every and all aspects thereto involve preserving life and the value of human capital, d, labor, capital and entrepreneurship, inclusive of, without limitation, preservation of physical, legal and/or financial assets, preservation of income interruption and elimination of conditions, initiatives, schemes, ocurrences, happenings, interactions, processes, methods, practices, movements, proceedings, messaging, presentations, notifications, filings, submissions, records, activities, actions, events, endeavors, tasks and affairs which may or may not lead to said damages, losses and/or injuries to personal and/or commercial oriented specified life, health, property, casualty, liabilities, valuables and/or factors, things, elements and/or courses of initiatives, schemes, ocurrences, happenings, interactions, processes, methods, practices, movements, proceedings, messaging, presentations, notifications, filings, submissions, records, activities, actions, events, endeavors, tasks and affairs and needs in a highly volatile and global marketplace. Whereas, it is an undeniable and evidentiary findings of fact, documented reference, logical scientific deduction and intuitive analytical reasoning that varying techniques, designs, systems, routines, devices, manners, modes, fashions, forms, formats, factors, objects, parts, segments, elements, components, constituents, ingredients, processes, methods and combinations of risk management and damage, loss and/or injury control involve every and all of accounting for premium payments, fixed assset values, turnover figures, budget controls, uninsured losses of payments, other forms of exposure related data, real estate hold harmless and indemnity provisions, general liability and property protection or coverage, physicall address listings, human resource safety and loss preventions, declaration and claims controls, damage, loss and/or injury reporting, assessing and adjusting, purchasing hold harmless and indemnity provisions, purchasing insurance related provisions, legal contractual liabilities, new legal standards, procedures, processes and methodologies, operational cost allocations, inventory management, production allocation, distribution methodologies, marketing hold harmless and indemnity provisions, financing capital structure, busines planning, protection of property to secure debts, tax planning, requisition approvals, disbursement plans and methods, etc . . . . It is also an undeniable and evidentiary findings of fact, documented reference, logical scientific deduction and intuitive analytical reasoning that self-insurance plans and captive insurance carriers are legitimate, feasible and some are from any number of perspectives beneficial in any number of legal, regulatory, financial, economic, auditing, commercial, penal, statutory, penal and/or tax related methods, manners, processes, devices, systems and/or contexts offsetting the need to tap and/or utilize the insurance and/or reinsurance global marketplace. Every and all of these self-insurance plans and captive insurance related members of the aforementioned UNIVERSAL POPULACE™ may entail, encompass, comprise, involve, impact and/or effect substantial consideration of capital financing, formation, distribution, collection, allocation, disbursements, and assessments of actuarially assumed financial risks, exposures and capacities, which may involve voluntary and involuntary perils, variable risks and pure risks inclusive of, without limitation, frequent losses, excess losses, legal related regulatory filings, hearings, administration, declaration and claims handling, financial management, preparation and auditing of PUBLIC FINANCIALS™ statements with PUBLIC FINANCIALS™ instruments, and upstart capital outlays for services fees, taxes, excess premiums, computing capabilities, communications, utlity and electricity, office supplies, office furniture, aforementioned PUBLIC FINANCIALS™ instruments, travel, salary and wages, office rent, and/or on-going value assessments from every and all applicable regulatory bodies and/or agencies. With respect to value and taxable assessments from regulatory bodies and/or agenices these may involve loss reserve requirements, insuring capacity limits, financial solvency, administrative management, governmental operating funds, surety, fidelity and guaranty funds, declaration and claims handlings processes, premium rating methdologies, scientific actuarial capabilities, etc . . . . Whereas, it is an undeniable and evidentiary findings of fact, documented reference, logical scientific deduction and intuitive analytical reasoning that the tax deductability of components, constituents, ingredients, processes, methods and combinations of self-insurance plans and captive insurance related members of the aforementioned UNWVERSAL POPULACE™ inclusive of, without limitation, the ability to bypass the insurance related members of the aforementioned UNIVERSAL POPULACE™ and access the reinsurance marketplace of the global economy represent any one or a number of benefits of establishing such commercial oriented business initiatives, schemes, ocurrences, happenings, interactions, processes, methods, practices, movements, proceedings, messaging, presentations, notifications, filings, submissions, records, activities, actions, events, endeavors, tasks and affairs albeit a self-insurance plan may not be capable of treating its loss experiences as business oriented expenses until such losses are actually paid out upon actualizing confirmation and verification of declarations and claims. Whereas, it is an undeniable and evidentiary findings of fact, documented reference, logical scientific deduction and intuitive analytical reasoning that a captive insurance related public organization can take every and all techniques, designs, systems, routines, devices, manners, modes, fashions, forms, formats, factors, objects, parts, segments, elements, components, constituents, ingredients, processes, methods and combinations of categorization which may involve type of insured and/or types of insurance protection or coverage provided, and further the categorization of a captive insurance related public organization ownership status may involve single owner, multiple owners, pools, rent-a-captive, and/or profit centers. The idea and concepts related to categorization pertaining to insured and types of insurance protection or coverage can also be subcategorized as related insureds captives wherein these represent actuarially assumed financial transactional exchange risks accepted only for the owners and/or members of an economic family members of the aforementioned UNIVERSAL POPULACE™ which may be inclusive of, without limitation, single parent, multiple parent and risk retention groups of captive insurance related members of the aforementioned UNIVERSAL POPULACE™, and in contrast non-related insured captives involve actuarially assumed financial transactional exchange risk to offer insurance protection or coverage to their owners, but therewithal are distinctively separate and traditionally exclusive in allowing or accepting the actuarially assumed clearly recognized and fully appreciated understanding of the distinctively separate and traditionally exclusive techniques, designs, systems, routines, devices, manners, modes, fashions, forms, formats, factors, objects, parts, segments, elements, components, constituents, ingredients, processes, methods and combinations pertaining to the categorization of a captive insurance related public organization evinces that a single owner captive is owned by one related public organiations, wherein it may actuarially assume financial transactional exchange risk for the parent/owner, and/or other similar or differentiated forms of insureds. The main premise for a single owner captive insurance related public organization to actuarially assume financial transactional exchange risk of other similar or differentiated forms of insureds is so the parent/owner can capitalize on the tax deductability fo the premiums it pays to the captive insurance related public organization. Moreover, multiple owner captive insurance related members of the aforementioned UNIVERSAL POPULACE™ can further be categorized as risk retention groups, association groups and agency groups, wherein a risk retention group is controlled by the Risk Retention Act of 1986 enabling such public organization to actuarially assume financial transactional exchange risk authorized but restricted by law and which is further designed to meet the insurance protection or coverage needs of a narrowly defined group of homogeneous potential unknown or unforessen damages, losses and/or injuries. In contrast thereto, a association group captive insurance related public organization is not subject to the same restrictive extent of actuarially assuming financial transactional exchange risk, but wherein the members with insurance protection or coverage needs converge to form as association specifically to transport their homogeneous potential unknown or unforessen damages, losses and/or injuries, and moreover an agency group capitive related public organization is typically formed by insurance related brokers and insurance related agents wherein said public organization increases every and all potential capacity to meet the broader insurance protection or coverage needs of the policies and/or contracts placed by them respectively as related brokers and agents for the benefit of their clients. Furthermore, a pools oriented captive insurance related public organization are formed by self-insurance plans and captive insurance related members of the aforementioned UNIVERSAL POPULACE™ that segments, elements, components, constituents, ingredients, processes, methods and combinations of the actuarially assumed financial transactional exchange risks they have previously accepted from present insured members of the aforementioned UNIVERSAL POPULACE™ and/or individual consumers for whom said risks have already been ssumed or accepted. The idea and concept behind a rent-a-captive oriented captive insurance related public organization is somewhat specialized and distinctively exclusive from every and all other capitive ownership categorizations because they are designed formembers of the aforementioned UNIVERSAL POPULACE™ that do not desire or wish to outright own a captive related public organization, but nevertheless desire or wish to capitalize on some of the advantages of such insurance protection or coverage inclusive of, without limitation, every and all operational, financial and transactional exchange benefits available therein. Thereof, rent-a-captive oriented captive insurance related public organization is generally formed by a group of depositors and operating as an income-producing commercial business oriented initiatives, schemes, ocurrences, happenings, interactions, processes, methods, practices, movements, proceedings, messaging, presentations, notifications, filings, submissions, records, activities, actions, events, endeavors, tasks and affairs, wherein any one or a number of insureds make and/or maintain premium payments and/or deposits, and further provides or posts letters of credit to offer every and all techniques, designs, systems, routines, devices, manners, modes, fashions, forms, formats, factors, objects, parts, segments, elements, components, constituents, ingredients, processes, methods and combinations of guaranty and security related to said potentially income producing commercial business oriented initiatives, schemes, ocurrences, happenings, interactions, processes, methods, practices, movements, proceedings, messaging, presentations, notifications, filings, submissions, records, activities, actions, events, endeavors, tasks and affairs, and operators are hired to manage the administration of the enterprise while the reinsurance market is utilized to minimize actuarially assumed risk exposures and insureds subsequent to the specific time period of insurance protection or coverage may or may not bepaid a dividend premised on the rent-a-captive's loss experience, operating expenses and the inherent costs of reinsuring its actuarially assumed risk exposures. The profit center oriented captive preferred stocks, and the transactional exchange is categorized as additional paid-in-capital to offset the making or maintenance of predetermined rates and/or risk premiums effectuated by the insured to the profit center oriented captive insurance related public organization. The insured desiring or wishing to receive insurance protection or coverage via the profit center is thereupon insured by a fronting public organization who applies for a certificate of authority from regulatory authorities to actuarially assume financial transactional exchange risks on behalf of the owners of the captive insurance related public organization and adminstratively manages declarations and claims related thereto, but thereupon reinsures these actuarially assumed financial transactional exchange risks of the insured with the profit center, wherein the fronting public organization manages the loss prevention programs, administers every and all related details pertaining to the insurance protection or coveage of the insured, and disburses payments on declarations and claims received thereto while simultaneously pursuing reimbursements from the profit center, and upon closure of the specified time or accounting period of the insurance protection or coverage the insured may be receive a dividend on the non-voting preferred stock if the potentially income producing commercial business oriented initiatives, schemes, ocurrences, happenings, interactions, processes, methods, practices, movements, proceedings, messaging, presentations, notifications, filings, submissions, records, activities, actions, events, endeavors, tasks and affairs returned a profit, otherwise no dividend payment is distributed to the insured members of the aforementioned UNIVERSAL POPULACE™. As previously noted, every and all techniques, designs, systems, routines, devices, manners, modes, fashions, forms, formats, factors, objects, parts, segments, elements, components, constituents, ingredients, processes, methods and combinations of insurance, reinsurance, and alternative risk management vehicles such as self-insurance plans and captive insurance related members of the aforementioned UNIVERSAL POPULACE™ actuarially assume financial transactional exchange risk of potential unknown and unforeseen suffering of damages, losses and/or injuries that pertain and/or involve life and health related protection or coverage inclusive of, without limitation, every and all techniques, designs, systems, routines, devices, manners, modes, fashions, forms, formats, factors, objects, techniques, designs, systems, routines, devices, manners, modes, fashions, forms, formats, factors, objects, parts, segments, elements, components, constituents, ingredients, processes, methods and combinations of insurance, reinsurance, and alternative risk management vehicles such as self-insurance plans and captive insurance related members of the aforementioned UNIVERSAL POPULACE™ actuarially assume financial transactional exchange risk of potential unknown and unforeseen suffering of damages, losses and/or injuries that pertain to property and casualty oriented protection or coverage inclusive of, without limitation, every and all techniques, designs, systems, routines, devices, manners, modes, fashions, forms, formats, factors, objects, parts, segments, elements, components, constituents, ingredients, processes, methods and combinations of primary, secondary, stop-loss, excess and umbrella protection or coverages, and therein may concretize requisite techniques, designs, systems, routines, devices, manners, modes, fashions, forms, formats, factors, objects, parts, segments, elements, components, constituents, ingredients, processes, methods and combinations of initial deductibles assumed as financial transactional exchange risk by the insured and/or annuitant. The commercial oriented business initiatives, schemes, ocurrences, happenings, interactions, processes, methods, practices, movements, proceedings, messaging, presentations, notifications, filings, submissions, records, activities, actions, events, endeavors, tasks and affairs involved in forming a captive insurance related public organization may requisite much larger out-of-pocket costs related to the establishment of a separate legal public organization, organizational structure and aforementioned PUBLIC FINANCIALS™ instruments invements, which is not a required for self-insurance plans, but it may also require the full-time services of employee staff personnel and/or an experienced management group to provide every and all necessary supervisory oversight and regulatory authority over the actuarial assumption of financial transactional exchange risk, legal services, declaration and claims, loss prevention and preservation, operational guidelines, and the varying inefficient arts and ineffective science of so-called actuaries. There are numerous benefits of establishing a captive insurance related public organization of which every and all may involve lower cost structure regarding the procurement of protection or coverage which therein bypass every and all acquisition of of an insurance related public organization to subsidize the large bureaucracy it requires to offer its functional business services to the global marketplace. Moreover, other such benefits of establishing a captive insurance related public organization may also lower the costs structure pertaining to procurement of protection or coverage from reinsurance related members of the aforementioned UNIVERSAL POPULACE™ which may not be accessible to a public organization or individual consumers who are not participants in commercial oriented business initiatives, schemes, ocurrences, happenings, interactions, processes, methods, practices, movements, proceedings, messaging, presentations, notifications, filings, submissions, records, activities, actions, events, endeavors, tasks and affairs of an insurance related public organization. Furthermore, captive insurance related members of the aforementioned UNIVERSAL POPULACE™ are less vulnerable to the artificial increases and/or decreases in predetermined rates and/or risk premiums charged by insurance related members of the aforementioned UNIVERSAL POPULACE™ for procuring protection or coverage related to suffering specified damages, losses and/or injuries pertaining to specified life, health, property, casualty, liabilities, valuables and/or factors, things, elements and/or courses of initiatives, schemes, ocurrences, happenings, interactions, processes, methods, practices, movements, proceedings, messaging, presentations, notifications, filings, submissions, records, activities, actions, events, endeavors, tasks and affairs in every and all techniques, designs, systems, routines, devices, manners, modes, fashions, forms, formats, factors, objects, parts, segments, elements, components, constituents, ingredients, processes, methods and combinations concretizing as acts or occurances during the specific time period of the formal and legally binding contract period in exchange for a counter-party and/or Third Party members of the aforementioned UNIVERSAL POPULACE™ or clients, customers, consumers, member-subscribers, constituents, creditors, shareholders, stakeholders, so-called U.S. depositors, so-called U.S. citizen taxpayers or members of the aforementioned UNIVERSAL POPULACE™ making and/or maintaining periodic predetermined rates and/or risk premiums related financial monetary payments to the insurance related public organization. Therefore, it is clearly an undeniable and evidentiary findings of fact, documented reference, logical protection or coverage for their owners when standard insurance related members of the aforementioned UNIVERSAL POPULACE™ artificially increase their predetermined rates and/or risk premiums by pooling actuarially assumed financial transactional exchange risk with other captive insurance related members of the aforementioned UNIVERSAL POPULACE™, retaining the actuarially assumed financial risk internally within its own organizational structure, and further procuring every and all excess and/or umbrella reinsurance protection or coverage and/or transportring every and all of its actuarially assumed financial transactional exchange risk. It is also an undeniable and evidentiary findings of fact, documented reference, logical scientific deduction and intuitive analytical reasoning that a captive insurance related public organization has the flexibility of designing insurance and/or reinsurance protection or coverage to meet the more narrowly and/or broad specified desires and needs of the membership participants which may involve actuarial assumption of financial transactional exchange risk which otherwise would not be available and/or would be cost prohibitive in terms of procurement from a standard insurance related public organization, and additionally may formulate every and all narrow and/or braod specifications are comprehensively suitable, generally pertinent and broadly useful to their desired or wished excess or umbrella protections or coverages which thereupon can be offered to the reinsurance global marketplace at less cost of procurement and/or transport of said actuarially assumed financial transactional exchnge risk. One of the most beneficial reasons for establishment of a captive insurance related public organization focused on the narrow and/or broadly specified desires and needs pertaining to the procurement of protection or coverage is the flexibility in formulating an extremely efficient and effective loss prevention and preservation programs, whereby on-site spot invesigtations and/or inspections can be promulgated to ensure that every and all guidelines and safety related manuals are implemented, adhered to and complied with by the insured owners, and which thereupon can be extremely beneficial to a captive insurance related public organization which actuarially assumes financial transactional exchange risks involving counter-party and/or Third Party members of the aforementioned UNIVERSAL POPULACE™ or individual consumers. Furthermore, captive insurance related flexible are comprehensively suitable, generally pertinent and broadly useful to the making and/or maintaining of predetermined rates and/or risk premiums while being cognizant of loss reserve and solvency issues and matters and their access to high frequency losses and catastrophic severities mitigating by utilizing the reinsurance marketplace in contrast to self-insurance plans, but captive insurance related members of the aforementioned UNIVERSAL POPULACE™ must be as rigid as a standard insurance related public organization when actuarially assuming financial transactional exchange risks involving counter-party and/or Third Party members of the aforementioned UNIVERSAL POPULACE™ or individual consumers premised on issues and matter concering the income-producing capabilities of every and all techniques, designs, systems, routines, devices, manners, modes, fashions, forms, formats, factors, objects, parts, segments, elements, components, constituents, ingredients, processes, methods and combinations of these commercial oriented business initiatives, schemes, ocurrences, happenings, interactions, processes, methods, practices, movements, proceedings, messaging, presentations, notifications, filings, submissions, records, activities, actions, events, endeavors, tasks and affairs. Whereas, it is an undeniable and evidentiary findings of fact, documented reference, logical scientific deduction and intuitive analytical reasoning that because of the less than appropriate supervisory oversight and regulatory authority are comprehensively suitable, generally pertinent and broadly useful to the tax deductibility of predetermined rates and/or risk premiums involved in utilizing fronting arrangements under the notion of procuring protection or coverage from a captive insurance related public organization particularly in the 1970's and 1980's, the Internal Revenue Service challenged the use of fronting members of the aforementioned UNIVERSAL POPULACE™ for the purpose of deducting captive insurance related predetermined rates and/or risk premiums as a business expense item on the insured owners PUBLIC FINANCIALS™ statements and it won the case. Nevertheless, the utilization of fronting members of the aforementioned UNIVERSAL POPULACE™ involving captive insurance related members of the aforementioned UNIVERSAL POPULACE™ continues to be widely accepted barring this limiting provisions of not involving the predetermined rates and/or risk premiums as UNIVERSAL POPULACE™ however because of the liabilities of actuarially assumed financial transactional exchange risk fronting members of the aforementioned UNIVERSAL POPULACE™ retain a portion of the predetermined rates and/or risk premiums made and/or maintained by insured owner members because if the captive insurance related public organization becomes insolvent the fronting public organization is still liable for making compensatory financial related monetary payments on every and all declarations and/or claims. It is also an undeniable and evidentiary findings of fact, documented reference, logical scientific deduction and intuitive analytical reasoning that the so-called U.S. National Association of Insurance Commissioners (NAIC) inclusive of, without limitation, so-called U.S. states and many industrialized, developed and developing sovereign national countries promulgating development of model legilations aimed at establishing more responsible supervisory oversight and regulatory authority veer the, use of fronting members of the aforementioned UNIVERSAL POPULACETH in an effort to continue mitigating the tempestuous exponentially debilitating and tempestuous exponentially detrimental impacts of abuses which may have occurred during the insurance and reinsurance global marketplace insolvencies of the 1980's. Furthermore, there are various other techniques, designs, systems, routines, devices, manners, modes, fashions, forms, formats, factors, objects, parts, segments, elements, components, constituents, ingredients, processes, methods and combinations of inherent actuarially assumed financial transactional exchange risks involving the use of fronting members of the aforementioned UNIVERSAL POPULACE™ to apply for and acquire a certificate of authority, and subsequently requisite full and fair adherence to and compliance with to its adminstrative management of declarations and claims, implements and manages the loss prevention and preservation programs, and administers every and all related details pertaining to the insurance protection or coveage of the insured while disbursing payments on declarations and claims and simultaneously pursuing reimbursements as a Third Party administrative managemet public organizaation from the owner insured captive insurance related public organization. These various inherent actuarially assumed financial transactional exchange risks involve not retaining the services of experience staff personnel managers with training in operating, managing, simultaneously own the captive insurance related public organization from which the fronting public organization acquires reimbursements, develop and implement a systematic background check of the credentials and experience of every and all staff personnel managers hired by the fronting organization and/or the captive insurance related public organization, failing to properly handle every and all declarations or claims, and unscientifically arriving at unsubstantiated loss reserves which devised enormous unfunded losses for the Society of Lloyd's of London pertaining to pollution oriented asbestos claims. Furthermore, other inherent risks involve potentially not being capable of spreading the actuarially assumed financial transactional exchange risks across a homogeneous population thus mitigating every and all insolvency issues and matters which would otherwise occur with potentially unknown and unforeseen catastrophes and severity declarations or claims in contrast to the kernal premise of insurance, wherein reinsurance becomes a primary requisite of a captive insurance related public organization. Moreover, captive insurance related members of the aforementioned UNIVERSAL POPULACE™ inherently incure the potential of not being able to provide substantial narrow or broad specified adequate protection or coverage pertaining to unknown or unforeseen damages, losses and/or injuries for differentials among its large and small owner membership participants, occassionally power struggles can also be concretizing among any captives which are not single ownership structure pertaining to who will preside over and retain positions on the board of directors, and further those initially joining a captive may find themselves in a predicament of procuring claims made based policies under the captive wherein previously they may have been protected or coverted under occurrence based policies of vice versa. Other potential issues and matter are inherent to establishment and or participation in a captive insurance related public organization wherein methodologies and processess for arriving at actuarially predertermined rates and/or risk premiums may be flawed due to evidentiary findings of fact, documented reference, logical scientific deduction reasoning which concludes that claims handling methodologies and projections of loss reserves and claims handling expenses may not be premised on every and all real-time processing and/or reprocessing of data and/or information receiver necessary to properly project these figures, and constituents, ingredients, processes, methods and combinations of protection or coverage for differential groups which varying desires and needs may evince difficulty in acquiring access to every and all loss every and all real-time processing and/or reprocessing of data and/or information receiver pertaining to limits, similar forms of protections or coverages, and initially assumed deductibles every and all of which may lead to substantial problems when projecting unsubstantiated and artificially guessing what predetermined rates and/or risk premiums should be inclusive of, without limitation, the potential loss reserves which should be allocated including the claims handling expenses which may relate to any particular forms of protection or coverage for owner insured membership participants. Additionally, the allocation and management of loss reserves must be properly administered using appropriate and available aforementioned PUBLIC FINANCIALS™ instruments wherein said aforementioned PUBLIC FINANCIALS™ instruments would be readily convertible to currency to faciliate making compensatory financial related monetary payments on confirmed and verified declarations and claims related to the owner insured membership participants of the captive insurance related public organization, and the domicile of the captive insurance related public organization may requisite that every and all loss reserves be prudently deposited and properly managed in conservative forms aforementioned PUBLIC FINANCIALS™ instruments where letters of credit are not sufficient as resolution to the restrictive requisites of captives domicile. Other factors which may lead to problems and inevitably render captive insurance related members of the aforementioned UNIVERSAL POPULACE™ in a immdiate position of inherently assuming financial risks involve pursuing commercial oriented business initiatives, schemes, ocurrences, happenings, interactions, processes, methods, practices, movements, proceedings, messaging, presentations, notifications, filings, submissions, records, activities, actions, events, endeavors, tasks and affairs, which are not historically forms of insurance and reinsurance specialty areas where the captive insurance related public organization and its staff personnel managers display adequate experience and training, for the sole benefit of generating substantial cash flows to subsidize operating, financial or transactional exchange initiatives, schemes, ocurrences, happenings, interactions, processes, methods, practices, providing owner membership participants the highest degree of assurance that every and all said potential unknown and unforeseen damages, losses and/or injuries are protected or covered when declarations or claims are properly submitted to the fronting public organization which in turn pursues accuate, timely and verifiable reimbursement from the capital insurance related public organization. Every and all potential difficulties involving fronting members of the aforementioned UNIVERSAL POPULACE™ and captive insurance related members of the aforementioned UNIVERSAL POPULACE™ are typically identified via comprehensive counterpart comparisons aforementioned PUBLIC FINANCIALS™ statements inclusive of seamlessly and naturally wrapped, twisted, mixed, convoluted, embroidered and combined in connection with aforementioned PUBLIC FINANCIALS™ instruments with other captives and/or standard insurance related public orgaizations, and said aforementioned PUBLIC FINANCIALS™ statements inclusive of seamlessly and naturally wrapped, twisted, mixed, convoluted, embroidered and combined in connection with aforementioned PUBLIC FINANCIALS™ instruments is required to be independently audited and thereupon subsequently assessed by so-called U.S. state and/or national country insurance regulators to ensure that solvency tests, loss reserves requirements, and declaration and claims handling methdologies are properly adhered to and complied with at aW times Whereas, it is an undeniable and evidentiary findings of fact, documented reference, logical scientific deduction and intuitive analytical reasoning that the so-called U.S. National Association of Insurance Commissioners (NAIC) had developed an Insurance Regulatory information System (IRIS) from which comparative analytical ratios of standard insurance related members of the aforementioned UNIVERRAL POPULACE™, captive insurance related members of the aforementioned UNIVERSAL POPULACE™ and reinsurance related members of the aforementioned UNIVERSAL POPULACE™ are heretofore utilized to ensure that every and all requisite tests pertaining to solvency, prudent transactional exchange and management of loss reserve, actuarially assumed financial transactional exchange risks, loss prevention and preservation risk maangement guidelines, and accurate and verifiable handling, processing, disbursements and reimbursements conerning declarations and claims are actively scrutinzed to ensure that times. Furthermore, it is also an undeniable and evidentiary findings of fact, documented reference, logical scientific deduction and intuitive analytical reasoning that IRIS is thereupon and thereby utilized to ensure that every and all necessary aforementioned PUBLIC FINANCIALS™ statements inclusive of seamlessly and naturally wrapped, twisted, mixed, convoluted, embroidered and combined in connection with aforementioned PUBLIC FNANCIALST instruments is available to identifying and further depositigate commercial oriented business initiatives, schemes, ocurrences, happenings, interactions, processes, methods, practices, movements, proceedings, messaging, presentations, notifications, filings, submissions, records, activities, actions, events, endeavors, tasks and affairs of every and all standard insurance related members of the aforementioned UNIVERSAL POPULACE™, captive insurance related members of the aforementioned UNIVERSAL POPULACE™ and reinsurance related members of the aforementioned UNIVERSAL POPULACE™ are available to pursue every and all requisite actions and/or proceedings related to imposing requisite sanctions and adjustments pertaining to the accurate and verifiable handling, processing, disbursements and reimbursements conerning declarations and claims of protection or coverage of every and all forms of insurance and reinsurance related issues and mattters. Therewithal, to acquire an entire conceptual, clearly recognized and full appreciation of the utility engineering and architectural design propagations universal microprocessor computing design provisional benefits of aforementioned UCMOST™ information technology as applied to the areas involving insurance and reinsurance related members of the aforementioned UNIVERSAL POPULACE™ inclusive of, without limitation, their continuous public captital market securities aforementioned PUBLIC FINANCIALS™ instruments transactional exchange initiatives, schemes, ocurrences, happenings, interactions, processes, methods, practices, movements, proceedings, messaging, presentations, notifications, filings, submissions, records, activities, actions, events, endeavors, tasks and affairs with aforementioned fragmenting capital market inefficiencies, it should be understood that although it is an undeniable and evindentiary findings of fact, documented reference, logical scientific deduction reasoning aforementioned UCMOST™ information technology is not even remotely obvious to concern every and all of the distinctively separate and traditionally exclusive specialty areas of the efficient, effective, functional and integrated streamlined, alternating scale, inseparable, seamless and natural wrapping, interlacing, coiling, coupling, combining and interlocking techniques, designs, systems, routines, devices, manners, modes, fashions, forms, formats, factors, objects, parts, segments, elements, components, constituents, ingredients, processes, methods and combinations entailing, encompassing, comprising, involving, impacting and/or effecting every and all in the specialty areas of standard insurance, captive and reinsurance oriented business initiatives, schemes, ocurrences, happenings, interactions, processes, methods, practices, movements, proceedings, messaging, presentations, notifications, filings, submissions, records, activities, actions, events, endeavors, tasks and affairs. It is also an undeniable and evidentiary findings of fact, documented reference, logical scientific deduction and intuitive analytical reasoning that every and all techniques, designs, systems, routines, devices, manners, modes, fashions, forms, formats, factors, objects, parts, segments, elements, components, constituents, ingredients, processes, methods and combinations of marketing and/or offering to seamlessly and naturally the placement of a formal and legally binding contract agreement between members of the aforementioned UNIVERSAL POPULACE™ and a standard insurance related public organization, captives related public organization and reinsurance related public organization as a means of indemnifying and/or providing compensatory financial related monetary payments and/or distributions or reimbursements pertaining declarations or claims made pertinent to protection or coverage from unknown and unforeseen potentially suffering of damages, losses and/or injuries involving every and all techniques, designs, systems, routines, devices, manners, modes, fashions, forms, formats, factors, objects, parts, segments, elements, components, constituents, ingredients, processes, methods and combinations of specified life, health, property, casualty, liabilities, valuables and/or factors, things, elements and/or courses of initiatives, schemes, ocurrences, happenings, interactions, processes, methods, practices, movements, proceedings, messaging, presentations, notifications, filings, submissions, records, activities, actions, events, endeavors, tasks and affairs and needs in a highly volatile and global marketplace requires that every and POPULACE™ and reinsurance related members of the aforementioned UNIVERSAL POPULACE™ provide fill disclosure, best practices, best executions, enhanced fairness, simultaneous equality, full transparency, consolidated access and perpetual integration of members members of the aforementioned UNIVERSAL POPULACE™ aforementioned PUBLIC FINANCIALS™ statements inclusive of seamlessly and naturally wrapped, twisted, mixed, convoluted, embroidered and combined in connection with aforementioned PUBLIC FINANCIALS™ instruments be made available to members of the aforementioned UNIVERSAL POPULACE™. Whereas, it is an undeniable and evidentiary findings of fact, documented reference, logical scientific deduction and intuitive analytical reasoning that members of the aforementioned UNIVERSAL POPULACE™ typically discount the wage income earings from paychecks distributed for personnel employment services to ensure they are offered protection or coverage pertaining to specified life, health, property, casualty, liabilities, valuables and/or factors, things, elements and/or courses of initiatives, schemes, ocurrences, happenings, interactions, processes, methods, practices, movements, proceedings, messaging, presentations, notifications, filings, submissions, records, activities, actions, events, endeavors, tasks and affairs, and therefore no legally justifiable and substantive reasoning should exist wherein every and all such standard insurance related members of the aforementioned UNIVERSAL POPULACE™, captives related members of the aforementioned UNIVERSAL POPULACE™ and reinsurance related members of the aforementioned UNIVERSAL POPULACE™ would wish to obscure their treasure accounting, financial fueling and econometric energizing from every and all insureds, who in exchange for the counter-party and/or Third Party members of the aforementioned UNIVERSAL POPULACE™ or clients, customers, consumers, member-subscribers, constituents, creditors, shareholders, stakeholders, so-called U.S. depositors, so-called U.S. citizen taxpayers, foreign national depositors, foreign national taxpayers, members of the aforementioned UNIVERSAL POPULACE™ making and/or maintaining periodic predetermined rate and/or risk premium related financial monetary payments to the standard insurance related public organization, captive insurance related public organization, and indirectly to the reinsurance related public organization is simply elements, components, constituents, ingredients, processes, methods and combinations in transactional exchange oriented commercial business initiatives, schemes, ocurrences, happenings, interactions, processes, methods, practices, movements, proceedings, messaging, presentations, notifications, filings, submissions, records, activities, actions, events, endeavors, tasks and affairs which requires under law for every and all surplus and/or loss reserves to be deposited inaforementioned PUBLIC FINANCIALS™ instruments with aforementioned fragmenting capital market inefficiencies. Within an article published in the Miami Herald dated Mar. 7, 2001, it was reported that the same major, extremely prominet and well-established so-called U.S. banking, securities and insurance related public organization referenced in the article published in the Miami Herald dataed Mar. 3, 2001, concerning its engaging in money laundering initiatives involving drug trafficking and corruption related initiatives, schemes, ocurrences, happenings, interactions, processes, methods, practices, movements, proceedings, messaging, presentations, notifications, filings, submissions, records, activities, actions, events, endeavors, tasks and affairs via the use of shell oriented correspondent banks with accounts in its New York City headquarters, has also been sued by the Federal Trade Commission (FTC) for engaging in past practices which involved utlizing misleading statements and half-truths as well as extensive use of deceptive lending practices to manipulate members of the aforementioned UNIVERSAL POPULACE™ into purchasing mortages and undeniable, unnecessary, undeniable, unnecessary, unwarranted, illogical, unjustifiable, unreasoned and unmitigated, illogical, unjustifiable and unreasoned credit insurance which embodied artificially inflated prices beyond the nature of the undeniable, unnecessary, unwarranted, illogical, unjustifiable, unreasoned and unmitigated protection or coverage the credit insurance was providing the consolidated mortgage related loans. According to the FTC which is seeking a US$500 million on behalf of the vitimized members of the aforementioned UNIVERSAL POPULACE™ this one major, extremely prominet and well-established so-called U.S. banking, securities and insurance related public organization manipulated consumers into consolidating their debts into a single mortgage related debt bond oriented loan package by fraudulently marketing, promoting, touting, raptorial and advertising that they would related bond payments they were previously incurring. Whereas, it is an undeniable and evidentiary findings of fact, documented reference, logical scientific deduction and intuitive analytical reasoning that this one major, extremely porminet and well-established so-called U.S. banking, securities and insurance related public organization inappropriately preyed on unknowing, unsophisticated and now victimized members of the aforementioned UNIVERSAL POPULACE™ with high-interest, high-cost debt bond related consolidated loans which entailed its engaging in extensive utlization of deceitful and predatory practices which involved use of abusive tactics to collect payments from victimized consumers, and which evidently misled already debt bond related burdened consumers into new loans which clearly embodied high interest rates, artifcial fees and so-called closing costs. Whereas, it is an undeniable and evidentiary findings of fact, documented reference, logical scientific deduction and intuitive analytical reasoning to acknowledge that this one major, extremly prominent and well-established so-called U.S. banking, securities and insurance related public organization engaged in these predatory and abusive tactics to mislead consumers into purchasing these consolidated loans on a nationwide basis which entailed the public organization rushing consumers via the process of closing on the loans and discouraging them from removing and thereby purchasing the unknown and unncessary credit insurance products by real-time automatizingally including them in the monthly debt bond oriented repayments which added thousands of so-called U.S. dollars in unncessary debt on these already debt burdened consumers. The FTC has vowed to pursuit civil remedies on behalf of the countless number of vitimized consumers via seizure of US$500 million in undeniable, unnecessary, unwarranted, illogical, unjustifiable, unreasoned and unmitigated and unjustified and substantially artificially inflated predetermined rate and/or risk premiums and so-called closing costs pertaining to mortage related credit insurance policies embedded in these debt bond oriented consolidated loans. Additionally, according to the FTC suit against this one major, extremely prominent and well-established so-called U.S. banking, securities and insurance related public organization also violated numerous federal rules and regulations by willing engaging in abusive and harrassing collection tactics involving communications to consumers which involved leveraging credit report consumers to deceive, prey upon, mislead and abuse. Furthermore, the FTC charges this one major, extremely prominent and well-established so-called U.S. banking, securities and insurance related public organization also violated numerous federal rules and regulations by willing engaging in failing to keep proper records pertaining to its abusive, harrassing, deceptive, misleading, predatory practices, and fraudulently marketing, promoting, touting, raptorial and advertising false statements which are all comprehensively unsuitable, generally impertinent and broadly useless related to the aim, letter, nature, breadth, sound, depth and scope of a member an efficient capital market within, throughout and transcending a single holistically econometric marketplace environment. Within an article published in the Miami Herald dated Mar. 7, 2001, a vivid example of the wide-spread misuse of banking products and insurance related protection or coverage involving coupling and combinatorial industries and sectors within the aforementioned efficient UNIVERSAL ECONOMY™ which promulgate fraudulent, conspiring and corruptive practices entail, encompass, comprise, involve, impact and/or effect every and all techniques, designs, systems, routines, devices, manners, modes, fashions, forms, formats, factors, objects, parts, segments, elements, components, constituents, ingredients, processes, methods and combinations of unsuitable and inappropriate tactics utilized, charge and/or imposed on members of the aforementioned UNIVERSAL POPULACE™ under the guise offering legal every and all real-time processing and/or reprocessing of data and/or information receiver content management, financial services and public aforementioned PUBLIC FINANCIALS™ instruments finanical transactional exchange instrument commercial oriented transactional exchange driven initiatives, schemes, ocurrences, happenings, interactions, processes, methods, practices, movements, proceedings, messaging, presentations, notifications, filings, submissions, records, activities, actions, events, endeavors, tasks and affairs which pertain to artificially increase the so-called inflationary rates and/or premiums involved the State of Florida Department of Banking and Finance charging a Miami-based automobile dealership with assessing illegal finance changes concerning billing for unsupported insurance, and improper registration of tags and titles related to consumers purchase of an automobile from its dealership. The State of Florida Department of finance charges which were in fact a duplicate charge already included in the purchase price of the automobile, while other consumers were charged artificial interests rates on bank loans seamlessly and naturally wrapped, twisted, mixed, convoluted, embroidered and combined in connection with artificial predetermined rates and/or risk premiums for insurance related products wherein tag and title registration fees were also unnecessarily imposed in duplicate in letter, scope and nature those services offered directly by the State of Florida for proper licensing and registration of property. Furthermore, as it pertains to standard insurance and reinsurance related commercial oriented transactional exchange driven initiatives, schemes, ocurrences, happenings, interactions, processes, methods, practices, movements, proceedings, messaging, presentations, notifications, filings, submissions, records, activities, actions, events, endeavors, tasks and affairs it is also an undeniable and evidentiary findings of fact, documented reference, logical scientific deduction and intuitive analytical reasoning that every and all obscurity to accurate, reliable, timely and verifiable techniques, designs, systems, routines, devices, manners, modes, fashions, forms, formats, factors, objects, parts, segments, elements, components, constituents, ingredients, processes, methods and combinations aforementioned PUBLIC FINANCIALS™ statements inclusive of seamlessly and naturally wrapped, twisted, mixed, convoluted, embroidered and combined in connection with aforementioned PUBLIC FINANCIALS™ instruments concerning insurance and reinsurance related members of the aforementioned UNIVERSAL POPULACE™ concerning full disclosure of the operational, financial and transactional exchange performance and profitability of insurance related members of the aforementioned UNIVERSAL POPULACE™, captive insurance related members of the aforementioned UNIVERSAL POPULACE™ and reinsurance related members of the aforementioned UNIVERSAL POPULACE™ ultimately concretizes impulsive and stampede oriented reactions from members of the aforementioned UNIVERSAL POPULACE™ creating frantic, frenzied, freaking, frightened and/or spooked panic striken transactional oriented buying and selling are comprehensively suitable, generally pertinent and broadly useful to their expectations, anticipations, hopes, wishes, desires, concerns, uncertainties and fears which as referenced herein also inevitably leads to tempestuous exponentially inefficiencies. Thererewithal, every and all insurance, captive and reinsurance related members of the aforementioned UNIVERSAL POPULACE™ as herein evinced, documented and logically reasoned are dependent on the valuations aforementioned PUBLIC FINANCIALS™ instruments with aforementioned fragmenting capital market inefficiencies to maintain their internal treasure accounting, financial fueling and econometric energizing thereby enabling them to effectively make compensatory finacial related monetary payments on declarations or claims made pertaining to policies and/or contract of protections or coverages which have been legally transacted between themselves and members of the aforementioned UNIVERSAL POPULACE™ the aforementioned efficient UNIVERSAL ECONOMY™.Whereas, it is an undeniable and evidentiary findings of fact, documented reference, logical scientific deduction and intuitive analytical reasoning that the recent display of exponential tempestuous devaluation aforementioned PUBLIC FINANCIALS™ instruments with aforementioned fragmenting capital market inefficiencies evinces a tremendously long-held and enormously heart-felt need in the relevant art for innovative panacean cutting-edge technologically panacean cutting-edge innovative developments and technological advancements which concretize techniques, designs, systems, routines, devices, manners, modes, fashions, forms, formats, factors, objects, parts, segments, elements, components, constituents, ingredients, processes, methods and combinations of compositions that are intrinsically and integrally twisted, bundled and combinatorial panacean cutting-edge graphical user interfaces, proprietary software programs, software program icons, proprietary operating systems programs, and proprietary operating systems program icons, tailored around innovative techniques, designs, systems, devices, processes, parts, segments, methods, combinations, know-how, ideas, art forms, articles of manufacture, discoveries, formulae, and architectural engineering of streamlined procedural computing process design compositions to offer members of the aforementioned UNIVERSAL POPULACE™ innovative groundbreaking and breakthrough utility engineering and architectural design propagations universal microprocessor computing design provisions to meet the unmet needs of individual members of the aforementioned UNIVERSAL POPULACE via invoking aforementioned UCMOST information technologies which reprocessing of data and/or information content management, financial services and aforementioned PUBLIC FINANCIALS™ instruments needs members of the aforementioned UNIVERSAL POPULACE™ within an aforementioned efficient UNIVERSAL CAPITAL MARKET™ which are capable of tempestuous diminishing undeniable, unnecessary, undeniable, unnecessary, unwarranted, illogical, unjustifiable, unreasoned and unmitigated, illogical, unjustifiable and unreasoned tempestuous exponentially detrimental increases in systematic volatility and mitigating tempestuous exponentially debilitating increases in the cost of capital in a single holistically econometric marketplace environment.

9. Public Capital Maket Accounting

Whereas, it is an undeniable and evidentiary findings of fact, documented reference, logical scientific deduction and intuitive analytical reasoning that within the present highly dynamic and inherently volatile, fragile, frigid and ruthless global economic marketplace there exists undeniable, unnecessary, unwarranted, illogical, unjustifiable, unreasoned and unmitigated timing inefficiencies entailing, encompassing, comprising, involving, impacting and/or effecting public accounting, transport reconciling, independent auditing and financial reporting inclusive of order-entry quotation, matching, execution, settlement and exchange of insurance, risk financing, credit, cash management, investment banking and aforementioned PUBLIC FINANCIALS™ instruments requirements aforementioned PUBLIC FINANCIALS™ statements which members of the aforementioned UNIVERSAL POPULACE™ whichever every and all are furthermore undeniably, logically, scientifically and intuitively deduced, apprehended and invoked as necessarily integrated, critically important and increasingly integral members of the aforementioned UNIVERSAL POPULACE™ generate, collect, tabulate, process, store, and sumbit to the so-called U.S. Securities and Exchange Commission (so-called U.S. SEC) inclusive of the aforementioned PUBLIC FINANCIALS™ statements which members of the aforementioned UNIVERSAL POPULACE™ whichever every and all are furthermore undeniably, logically, scientifically and intuitively deduced, tabulate, process, store, and submit to the so-called U.S. Department of Treasury via the ancient history Internal Revene Service (IRS) and thereupon in large majority disseminate for public review, analysis, scrutiny and audit via the members of the aforementioned UNIVERSAL POPULACE™ within the aforementioned fragmenting capital market inefficiencies. Whereas, it is an undeniable and evidentiary findings of fact, documented reference, logical scientific deduction and intuitive analytical reasoning that whichever respective aforementioned PUBLIC FINANCIALS™ instruments and aforementioned PUBLIC FINANCIALS™ statements from members of the aforementioned UNIVERSAL POPULACE™ whichever every and all are furthermore undeniably, logically, scientifically and intuitively deduced, apprehended and invoked as necessarily integrated, critically important and increasingly integral members of the aforementioned UNIVERSAL POPULACE™ invoked within aforementioned UCMOST™ information technology is comprehensively suitable, generally pertinent and broadly useful to intrinsically filing every and all domestic and/or expatriate domain certified periodic, interim and annual Personal Financial Statements (PFS) inclusive of certified payment on income, capital gains and/or other licenses, taxes, rates, assessments, charges, fees, tariffs, surcharges inclusive of every and all pricing, costing, operating, franchising, leasing, purchasing, financing and/or commissioning proposed, stipulated, substantiated, justified, verified, traversed, enacted, levied, imposed, rated, assessed, certified, propagating and subsequent promulgation respectively via legitimate and instrinsically certified hereto members of the aforementioned UNIVERSAL POPULACE™ legal filing and collection of payment of every and all obscurant, irresponsible, feculent, irrational, feckless, disrespectful, mendacious, ignorant, malicious, condescending, untruthful, insolent, inefficient, incognizant, ineffective, fragmenting, unlettered, unpolished, presumptuous, portentous, pretentious, fruitless, disparate, antiquated, archaic, ancient history and superannuated so-called U.S. Department of Treasury (so-called U.S. Treasury), ancient history internal revenue service agency generator scheduled and/or unscheduled Forms and Schedules inclusive of so-called U.S. Treasury Form 1040 in connection with applicable unitemized and basic so-called U.S. Treasury Schedule A, B, and D and/or so-called U.S. Treasury Form 1040-called U.S. Treasury Schedule C, wherefrom further hereto invoked within aforementioned UCMOST™ information technology is comprehensively suitable, generally pertinent and broadly useful to intrinsically certified filing every and all interim so-called U.S. Securities and Exchange Commission (so-called U.S. SEC) processing heretofore via the anciet history Electronic Data Gathering and Automated Retrieval (EDGAR) System wherefrom hereto interim so-called U.S. Form 8-K with a standard fifteen-day time-lagged inabsentia, hardship, inanition, skidding, stalling, hesitant, holding, refusing and restraining unscheduled aforementioned PUBLIC FINANCIALS™ statements, interim so-called U.S. SEC Form 10-Q with a standard forty-five time-lagged inabsentia, hardship, inanition, skidding, stalling, hesitant, holding, refusing and restraining aforementioned PUBLIC FINANCIALS™ statements, interim General Purpose Financial Statements (GPFS) aforementioned PUBLIC FINANCIALS™ statements, interim so-called U.S. SEC Form 10-QSB aforementioned PUBLIC FINANCIALS™ statements from small business registrants, interim so-called U.S. SEC Form SC-13G aforementioned PUBLIC FINANCIALS™ statements filings from beneficial owners, interim so-called U.S. SEC Form SC-13G/A aforementioned PUBLIC FINANCIALS™ statements amended filings from beneficial owners, interim so-called U.S. SEC Form DEF 13-F aforementioned PUBLIC FINANCIALS™ statements comprehensively suitable, generally pertinent and broadly useful to reporting on aforementioned PUBLIC FINANCIALS™ instruments from banking, securities, insurance related public organizations inlcusive of, without limitation, whichever furthermore transactional exchange advisers, transactional exchange companies, foundations, endownments and pension finds wherefrom hereto terminological denominatively part and form members of the aforementioned UNIVERSAL POPULACE™, interim so-called U.S. SEC Form DEF 14-A aforementioned PUBLIC FINANCIALS™ statements comprehensively suitable, generally pertinent and broadly useful to proxy voting from members of the aforementioned UNIVERSAL POPULACE™, interim so-called U.S. SEC Form 497 aforementioned PUBLIC FINANCIALS™ statements comprehensively suitable, generally pertinent and broadly useful to initial filing registration prospectus from transactional exchange company registration aforementioned PUBLIC FINANCIALS™ instruments from transactional exchange company related members of the aforementioned UNIVERSAL POPULACE™, interim so-called U.S. SEC Form N-30D aforementioned PUBLIC FINANCIALS™ statements comprehensively suitable, generally pertinent and broadly useful to semi-annual reporting from transactional exchange company related members of the aforementioned UNIVERSAL POPULACE™, initial so-called U.s. SEC Form 3 aforementioned PUBLIC FINANCIALS™ statements comprehensively suitable, generally pertinent and broadly useful to initial filing of directors, officers and persons or public organizations owning more than 10% of any class from members of the aforementioned UNIVERSAL POPULACE™, interim so-called U.S. SEC Form 4 aforementioned PUBLIC FINANCIALS™ statements comprehensively suitable, generally pertinent and broadly useful to filing intention of disolvement of positions from directors, officers and persons and/or public organizations owning more than 10% aforementioned PUBLIC FINANCIALS™ instruments of any class from members of the aforementioned UNIVERSAL POPULACE™, wherefrom further hereto annual so-called U.S. SEC Form 10-K with a standard ninety-day time-lagged inabsentia, hardship, inanition, skidding, stalling, hesitant, holding, refusing and restraining aforementioned PUBLIC FINANCIALS™ statements, annual Comprehensive Annual Financial Reports (CAFR) aforementioned PUBLIC FINANCIALS™ statements, annual so-called U.S. SEC Form 20-F aforementioned PUBLIC FINANCIALS™ statements and/or annual so-called U.S. SEC Form 5 aforementioned PUBLIC FINANCIALS™ statements respectively from domestic, foreign registrants and/or directors, officers and persons and/or public organizations owning more than 10% aforementioned PUBLIC FINANCIALS™ instruments of any class from members of the aforementioned UNIVERSAL POPULACE™ in combination with the aforementioned PUBLIC FINANCIALS™ instruments to effectuate management decisions regarding the operating performance, transactional exchange and financial profitability members of the aforementioned UNIVERSAL POPULACE™, wherefrom hereto evidently deriving, inducing and invoking further terminological denominative of every and all aforementioned PUBLIC FINANCIALS™ instruments as comprehensively suitable, within every and all aforementioned PUBLIC FINANCIALS™ statements traversing inclusive of, without limitation, every and all other industries and sectors in a single holistically econometric marketplace environment beyond the following specified multifaceted industries and multidimensional sectors entailing, encompassing, comprising, involving, impacting and/or effecting banking, securities and insurance, wherefrom hereto it is clearly an undeniable and evidentiary findings of fact, documented reference, logical scientific deduction and intuitive analytical reasoning that every and all of the interim aforementioned PUBLIC FINANCIALS™ statements from either members of the aforementioned UNIVERSAL POPULACE™ nor members of the aforementioned UNIVERSAL POPULACE™ are independently audited for the benefit of an aforementioned efficient UNIVERSAL CAPITAL MARKET™. It is also an undeniable and evidentiary findings of fact, documented reference, logical scientific deduction and intuitive analytical reasoning that the quarterly aforementioned PUBLIC FINANCIALS™ statements inclusive of seamlessly and naturally wrapped, twisted, mixed, convoluted, embroidered and combined in connection with aforementioned PUBLIC FINANCIALS™ instruments referred to as 10-Qs from public/private organizations are heretofore filed with the so-called U.S. SEC, and the quarterly aforementioned PUBLIC FINANCIALS™ statements inclusive of seamlessly and naturally wrapped, twisted, mixed, convoluted, embroidered and combined in connection with aforementioned PUBLIC FINANCIALS™ instruments referred to as General Purpose Financial Statements (GPFS) from government entities and not-for-profit organizations are heretofore filed with other hereto members of the aforementioned UNIVERSAL POPULACE™ bodies with an undeniable, unnecessary, unwarranted, illogical, unjustifiable, unreasoned and unmitigated standard forty-five day time-lagged hestiant, holding and restraining delay. Whereas, it is an undeniable and evidentiary findings of fact, documented reference, logical scientific deduction and intuitive analytical reasoning that the annual aforementioned PUBLIC FINANCIALS™ statements inclusive of seamlessly and naturally wrapped, twisted, mixed, convoluted, embroidered and combined in connection with aforementioned PUBLIC FINANCIALS™ instruments from public/private organizations referred to as 10-Ks are mixed, convoluted, embroidered and combined in connection with aforementioned PUBLIC FINANCIALS™ instruments from government entities and not-for-profit organizations referred to as Comprehensive Annual Financial Report (CAFR) are heretofore filed with other hereto members of the aforementioned UNIVERSAL POPULACE™ legal governing, regulatory, judicial, administrating, manageming and operating bodies with an undeniable, unnecessary, unwarranted, illogical, unjustifiable, unreasoned and unmitigated standard ninety-day time-lagged hestiant, holding and restraining delay. Furthermore, it is clearly an undeniable and evidentiary findings of fact, documented reference, logical scientific deduction and intuitive analytical reasoning that every and all of these necessary public accounting, transport reconciling, independent auditing and financial reporting inclusive of order-entry quotation, matching, execution, settlement and exchange of insurance, risk financing, credit, cash management, investment banking and aforementioned PUBLIC FINANCIALS™ instruments aspects, topics, issues, matters, elements, components, functions, devices, software, systems, methods, combinations, processes and procedures concerning aforementioned PUBLIC FINANCIALS™ statements inclusive of seamlessly and naturally wrapped, twisted, mixed, convoluted, embroidered and combined in connection with aforementioned PUBLIC FINANCIALS™ instruments are heretofore submitted from members of the aforementioned UNIVERSAL POPULACE™ and/or aforementioned UNIVERSAL POPULACE™ to so-called U.S. Treasury and the so-called U.S. SEC and other hereto members of the aforementioned UNIVERSAL POPULACE™ governing, regulatory, judicial managing, administrating and operating bodies subsequent to the respective quarterly or annual closing of what is heretofore an undeniable, unnecessary, unwarranted, illogical, unjustifiable, unreasoned and unmitigated time-lagged inabsentia, hardship, inanition, skidding, stalling, hesitant, holding, refusing and restraining accounting cycle herewith, present and hereafter unriddled herewith present and hereafter via an innovative technological solution to the tremendously long-held and enormously heart-felt unmet needs in the relevant art completely resolved via invoking the utlity and design aforementioned UCMOST™ information technology. In an effort at being adamant and extremly clear about varying charter, independent governing power and regulatory authority over every and all aspects topics, issues, matters, elements, components, functions, devices, software, systems, methods, combinations, processes and procedures pertaining to the aforementioned fragmenting capital market inefficiencies and is legally responsible for affording the highest levels of accuracy, quality, integrity, honor, timeliness, relevance, transparency, reliabilty, verifiability, comprehensiveness, understandability and assurance and utmost degrees of assurances to every and all members of the aforementioned UNIVERSAL POPULACE™ concerning every and all aspects, topics, issues, matters, elements, components, functions, devices, software, systems, methods, combinations, processes and procedures pertaining to the accuracy, quality, integrity, honor, timeliness, relevance, transparency, reliabilty, verifiability, comprehensiveness, understandability and assurance of the aforementioned PUBLIC FINANCIALS™ statements inclusive of seamlessly and naturally wrapped, twisted, mixed, convoluted, embroidered and combined in connection with aforementioned PUBLIC FINANCIALS™ instruments reported by members of the aforementioned UNIVERSAL POPULACE™ inclusive of, without limitation, every and all aforementioned PUBLIC FINANCIALS™ instruments transactional exchange data with aforementioned PUBLIC FINANCIALS™ instruments transactional exchange information with aforementioned fragmenting capital market inefficiencies. To reaffirm the premise are comprehensively suitable, generally pertinent and broadly useful to the exclusively vested legal charter, independent governing power and regulatory authority over the aforementioned fragmenting capital market inefficiencies, it is also an undeniable and evidentiary findings of fact, documented reference, logical scientific deduction and intuitive analytical reasoning that these timing inefficiencies have no legal justification and have always historically and pesently been completely and flagrantly outside of the legal requirements of public accounting, transport reconciling, independent auditing and financial reporting inclusive of order-entry quotation, matching, execution, settlement and exchange of insurance, risk financing, credit, cash management, investment banking and aforementioned PUBLIC FINANCIALS™ instruments inclusive of seamlessly and naturally wrapped, twisted, mixed, convoluted, embroidered and combined in connection with aforementioned PUBLIC FINANCIALS™ statements 1970, the so-called U.S. Department of Treasury Tax Code inclusive of every and all other tax and/or tariff codes of other hereto members of the aforementioned UNIVERSAL POPULACE™ governing, regulatory, judicial, operating, administrating and operating bodies. Whereas, it is an undeniable and evidentiary findings of fact, documented reference, logical scientific deduction and intuitive analytical reasoning that every and all unknown, unforeseen, unknowable, unlettered and unschooled skilled practicioners within the distinctively seperate and traditionally exclusive professions whereaforementioned UCMOST™ information technology is comprehensively suitable, generally pertinent and broadly useful completely failed to recognize and address the necessary, topics, issues, matters, elements, components, functions, devices, software, systems, methods, combinations, processes and procedures to devise a solution to completely resolve the tremendously long-held and enormously heart-felt needs in the relevant art applicable to the specialty areas of the efficient, effective, functional and integrated streamlined, alternating scale, inseparable, seamless and natural wrapping, interlacing, coiling, coupling, combining and interlocking techniques, designs, systems, routines, devices, manners, modes, fashions, forms, formats, factors, objects, parts, segments, elements, components, constituents, ingredients, processes, methods and combinations entailing, encompassing, comprising, involving, impacting and/or effecting automatizing real-time holistically steady state synchronized ubiquitous continuum real-time rhombus microprocessing instantaneous transmission and receiver transforming traverse conduit aformentioend UCMOST real-time processing and/or reprocessing involving every and all public accounting, transport reconciling, independent auditing and financial reporting inclusive of, without limtation, efficient, effective, functional and integrated streamlined, alternating scale, inseparable, seamless and natural wrapping, interlacing, coiling, coupling, combining and interlocking techniques, designs, systems, routines, devices, manners, modes, fashions, forms, formats, factors, objects, parts, segments, elements, components, constituents, ingredients, processes, methods and combinations entailing, encompassing, comprising, involving, impacting and/or effecting automatizing real-time holistically steady state synchronized ubiquitous continuum real-time rhombus microprocessing instantaneous transmission and receiver transforming and exchange of insurance, risk financing, credit, cash management, investment banking and aforementioned PUBLIC FINANCIALS™ instruments driven data and/or information content management, financial services and transactional elemental developments, necessary interactions and integral transactional exchange initiatives, schemes, ocurrences, happenings, interactions, processes, methods, practices, movements, proceedings, messaging, presentations, notifications, filings, submissions, records, activities, actions, events, endeavors, tasks and affairs. It is also an undeniable and evidentiary findings of fact, docuemented reference, logical scientific deduction and intuitive analytical reasoning that every and all unknown, unforeseen, unknowable, unlettered and unschooled and herewith unsuccessful skilled practicioners within the distinctively seperate and traditionally exclusive professions whereaforementioned UCMOST™ information technology is comprehensively suitable, generally pertinent and broadly useful whom present and hereafter attempt to risk their careers and reputations on unsubstantiated, illegal, illogical, unreasoned and archaic beliefs and theories that within the highly dynamic and inherently volatile, fragile, frigid and ruthless global economic marketplace of the information age we have now entered in the new millennium via propagating, promulgating and proclaiming every and all techniques, designs, systems, routines, devices, manners, modes, fashions, forms, formats, factors, objects, parts, segments, elements, components, constituents, ingredients, processes, methods and combinations of time-lagged inabsentia, hardship, inanition, skidding, stalling, hesitant, holding, refusing and restraining disclosures entailing, encompassing, comprising, involving, impacting and/or effecting every and all aforementioned PUBLIC FINANCIALS™ instruments inclusive of every and all necessarily integrated, critically important and increasingly integral aforementioned PUBLIC FINANCIALS™ statements from members of the aforementioned UNIVERSAL POPULACE™ inclusive of every and all necessarily integrated, critically important and increasingly integral members of the aforementioned UNIVERSAL POPULACE™ clearly fails to recognize, address and respect the tremendously long-held and enormously heart-felt undeniable, logical, reference, scientific, ethical, moral and technical unmet needs in the relevant art to propagating and promulgate full disclosure, best practices, best executions, enhanced accounting, transport reconciling, independent auditing and financial reporting inclusive of order-entry quotation, matching, clearance, execution, settlement and exchange of insurance, risk financing, credit, cash management, investment banking and aforementioned PUBLIC FINANCIALS™ instruments on behalf of the members of the aforementioned UNIVERSAL POPULACE™ as a premise to form and establish aforementioned efficient UNIVERSAL CAPITAL MARKET™ for a necessarily integrated, critically important and increasing integral aforementioned efficient UNIVERSAL ECONOMY™. Whereas, it is an undeniable and evidentiary findings of fact, documented reference, logical scientific deduction and intuitive analytical reasoning that every and all of the vast network of intermediary members of the aforementioned UNIVERSAL POPULACE™ within the distinctively separate and traditionally exclusive specialty areas entailing, encompassing, comprising, involving, impacting and/or effecting heretofore harming, damaging, inuring, insistent, insinuating, imposing, pestilent, impetuous, importune, pestiferous, condescending and insolent enthralling, hindering, entrapping, pretending, miring, fatiguing, maleficience, harassing, engulfing, pressing, malevolent, presuming, imprinting, malicious, suffocating, miring, strangling, repressing, entangling, pestering and oppressing every and all of the tremendously long-held and enormously heart-felt needs in the relevant art propagating and promulgate the aforementioned fragmenting capital market inefficiencies inclusive of every and all undeniable, unnecessary, unwarranted, illogical, unjustifiable, unreasoned and unmitigated time-lagged inabsentia, hardship, inanition, skidding, stalling, hesitant, holding, refusing and restraining disclosures because there is obviously a complete lack of proprietary innovative groundbreaking and breakthrough utility engineering and architectural design propagations invoked with the aforementioned UCMOST™ information technology, thus inevitably and continuously inflicting overwhelming negative, detrimental and debilitating every and all real-time processing and/or reprocessing of data and/or information receiver, financial services and transactional exchanges within the aforementioned fragmenting capital market inefficiencies. Therewithal, it is clearly an undeniable and evidentiary findings of fact, documented reference, logical scientific deduction and intuitive analytical reasoning that every and all and technological advancements of time-lagged inabsentia, hardship, inanition, skidding, stalling, hesitant, holding, refusing and restraining disclosures concerning the distinvely separate and traditionally exclusive speciality areas of public accounting, transport reconciling, independent auditing and financial reporting inclusive of order-entry quotation, matching, clearance, execution, settlement and exchange of insurance, risk financing, credit, cash management, investment banking and aforementioned PUBLIC FINANCIALS™ instruments from members of the aforementioned UNIVERSAL POPULACE™ inclusive of aforementiond UNIVERSAL POPULACE™ propagating tempestuous exponentially detrimental increasing systematic volatility and tempestuous exponentially increasing cost of capital within the aforementioned fragmenting capital market inefficiencies inclusive of promulgating booking, classifying, categorizing, adjusting, altering, revising, changing, charging, billing, collecting, producing, composing, conducting, proofing, filtering, pressing, publishing, cataloging, indexing, posting, compressing, releasing, playing, displaying, broadcasting, distributing and/or syndicating transmission, rebroadcasting, redistributing and/or resyndicating transmission, distributing and syndicating communicating conduits of conceptual aids heretofore as comprehensively imprudent, generally insolent and broadly unacceptable traversing of time-lagged inabsentia, hardship, inanition, skidding, stalling, hesitant, holding, refusing and restraining aforementioned PUBLIC FINANCIALS™ statements wherefrom every and all are heretofore undeniably, respectively, independently, autonomously, evidently, undeniably, logically, scientifically and intuitively herewith described, explained, referenced, specified and evinced is and/or are emphatically overburdening and excessively wide-spread contagion within the aforementioned fragmenting capital market inefficiencies. Whereas, it is an undeniable and evidentiary findings of fact, documented reference, logical scientific reasoning and intuitive analytical reasoning that every and all of the aforementioned further involve, concern and pertain to every and all techniques, designs, systems, routines, devices, manners, modes, fashions, forms, formats, factors, objects, parts, segments, elements, components, constituents, ingredients, processes, methods and combinations involving and/or related to public accounting, transport reconciling, independent auditing and financial reporting aforementioned PUBLIC FINANCIALS™ instruments from members of the aforementioned UNIVERSAL POPULACE™ inclusive of, without limitation, public accounting, transport reconciling, independent auditing and financial reporting aforementioned PUBLIC FINANCIALS™ instruments transactional exchange data with aforementioned PUBLIC FINANCIALS™ instruments transactional exchange information which embody every and all basic elemental developments, necessary interactions and integral transactional exchange initiatives, schemes, ocurrences, happenings, interactions, processes, methods, practices, movements, proceedings, messaging, presentations, notifications, filings, submissions, records, activities, actions, events, endeavors, tasks and affairs which are hereto discovered prevalent with aforementioned fragmenting capital market inefficiencies. The novel, unobvious, unique, unknown, unforeseen, unprecedented, ease of use and panacean cutting-edge technological innovation invoked within aforementioned UCMOST™ information technology is furthermore comprehensively suitable, generally pertinent and broadly useful utility and design formulation herewith existent innovative developments and technological advancements of every and all aforementioned PUBLIC FINANCIALS™ statements inclusive of seamlessly and naturally wrapped, twisted, mixed, convoluted, embroidered and combined in connection with aforementioned PUBLIC FINANCIALS™ instruments from members of the aforementioned UNIVERSAL POPULACE™ in combination with PUBLIC FINANCIALS™ transactional exchange instruments data with aforementioned PUBLIC FINANCIALS™ instruments non-financial information which are undeniably, respectively, independently, autonomously, evidently, undeniably, logically, scientifically and intuitively the exclusive drivers of every and all transactional exchange initiatives, schemes, ocurrences, happenings, interactions, processes, methods, practices, movements, proceedings, messaging, presentations, notifications, filings, submissions, records, activities, actions, events, endeavors, tasks and affairs, which is further are comprehensively suitable, generally pertinent and broadly useful to every and all aforementioned PUBLIC FINANCIALS™ statements inclusive of seamlessly and naturally wrapped, twisted, mixed, convoluted, embroidered and combined in connection with aforementioned PUBLIC evidently, undeniably, logically, scientifically and intuitively the exclusive drivers of every and all transactional exchange initiatives, schemes, ocurrences, happenings, interactions, processes, methods, practices, movements, proceedings, messaging, presentations, notifications, filings, submissions, records, activities, actions, events, endeavors, tasks and affairs, and further are comprehensively suitable, generally pertinent and broadly useful to every and all actualization of the formation and establishment of a novel, unobvious, unknown, unforeseen and unprecedented UNIVERSAL CAPITAL MARKET™ in a necessarily integrated, critically important and increasingly integral aforementioned efficient UNIVERSAL ECONOMY™ premised on an innovative panacean cutting-edge technological bridge oriented digital platform integrating and consolidating the distinctively separate and traditionally exclusive specialty areas of accounting, communicating, transporting, energizing, fueling, broadcasting, distributing and financing. The novel, unobvious, unique, unknown, unforeseen, unprecedented, ease of use and panacean cutting-edge technological innovation invoked within aforementioned UCMOST™ information technology is furthermore comprehensively suitable, generally pertinent and broadly useful utility and design formulation herewith existent innovative developments and technological advancements which are further are comprehensively suitable, generally pertinent and broadly useful to commercially forming and establishing a new theather of operations and higher standards for an aforementioned efficient UNIVERSAL CAPITAL MARKET™ which naturally and seamlessly integrates and consolidates the distintively separate and traditionally exclusive specialty areas of public accounting, transport reconciling, independent auditing and financial reporting inclusive of order-entry quotation, matching, clearance, execution, settlement and exchange of insurance, alternative risk management, credit, cash management, investment banking and aforementioned PUBLIC FINANCIALS™ instruments. The aforementioned UCMOST™ information technology is further a technological capable of mitigating every and all continued and perpetual harming, damaging, inuring, insistent, insinuating, imposing, pestilent, impetuous, importune, pestiferous, condescending and insolent enthralling, hindering, entrapping, pretending, miring, fatiguing, maleficience, harassing, engulfing, pressing, malevolent, POPULACE™ which are heretofore promulgated via the disticitvely separate and traditionally exclusive inefficient, ineffective, dysfunctional and fragmented vast networks of antiquated, archaic, ancient history and superannuated aforementioned PUBLIC FINANCIALS™ organizations which heretofore continuously, arrogantly, imprudently, irrationally and irresponsibly engage in propagating aforementioned fragmenting capital market inefficiencies via the communications via every and all of the traverse conduit conceptual aids within a single holistically econometric marketplace environment. Whereas, it is an undeniable and evidentiary findings of fact, documented reference, logical scientific reasoning and intuitive analytical reasoning that every and all of the aforementioned further involve, concern and pertain to every and all undeniably lead to tempestuous exponentially detrimental increases in the systematic volatility and tempestuous exponentially debilitating increases in the cost of capital with aforementioned fragmenting capital market inefficiencies. The preferential interests in selecting one aforementioned PUBLIC FINANCIALS™ instruments over another inclusive of, without limitation, the expectations, anticipations, hopes, wishes, desires, concerns, uncertainties and fears members of the aforementioned UNIVERSAL POPULACE™ inclusive of, without limitation, their trust and confidence in the senior executive of public organization and their transactional activity in the global marketplace are also negatively impacted by the numerous obscure UNIVERSAL CAPITAL MARKET™ inefficiencies which is tempestuous exponentially debilitating to their ability to protect, sustain and expand their treasure accounting, financial fueling and econometric energizing in a highly dynamic and inherently volatility environment which therewithal tempestuous exponentially detrimentally impacts the inherent capacity to sustain the valuation aforementioned PUBLIC FINANCIALS™ instruments and lower the cost of capital with aforementioned fragmenting capital market inefficiencies. The aforementioned UCMOST™ information technology is also a high-technological invention that establishes new and higher standards of full disclosure, best practices, best executions, enhanced fairness, simultaneous equality, full transparency, consolidated access and perpetual integration of members members of the aforementioned UNIVERSAL POPULACE™ in every and all basic elemental functional and integral notifications, filings, submissions, records, activities, actions, events, endeavors, tasks and affairs of an aforementioned efficient UNIVERSAL CAPITAL MARKET™ to thereupon assist members of the aforementioned UNWERSAL POPULACE™ ability to seamlessly and naturally effectuating efficient, effective, streamlined, objective, well-informed, risk-managed and self-assured aforementioned PUBLIC FINANCIALS™ instruments transactional exchange decision initiatives, schemes, ocurrences, happenings, interactions, processes, methods, practices, movements, proceedings, messaging, presentations, notifications, filings, submissions, records, activities, actions, events, endeavors, tasks and affairs in a single holistically econometric marketplace environment premised on enhanced fairness, simulteanoues equality, full transparency, consolidated access and perpetual integration to aforementioned PUBLIC FINANCIALS™ statements inclusive of seamlessly and naturally wrapped, twisted, mixed, convoluted, embroidered and combined in connection with aforementioned PUBLIC FINANCIALS™ instruments seamlessly and naturally wrapped, twisted, mixed, convoluted, embroidered and combined in connection with aforementioned PUBLIC FINANCIALS™ instruments transactional exchange data with aforementioned PUBLIC FINANCIALS™ instruments transactional exchange information which is further developed on a foundation of ensuring fill disclosure, best practices, best executions, enhanced fairness, simultaneous equality, full transparency, consolidated access and perpetual integration of members members of the aforementioned UNIVERSAL POPULACE™ in every and all techniques, designs, systems, routines, devices, manners, modes, fashions, forms, formats, factors, objects, parts, segments, elements, components, constituents, ingredients, processes, methods and combinations basic elemental developments, necessary interactions and integral transactional exchange initiatives, schemes, ocurrences, happenings, interactions, processes, methods, practices, movements, proceedings, messaging, presentations, notifications, filings, submissions, records, activities, actions, events, endeavors, tasks and affairs with aforementioned fragmenting capital market inefficiencies. The aforementioned UCMOST™ information technology as a high-technological invention also involves the development of innovative groundbreaking and breakthrough utility engineering and architectural design impact and bridge the distinctively separate and traditionally exclusive specialty areas of the efficient, effective, functional and integrated streamlined, alternating scale, inseparable, seamless and natural wrapping, interlacing, coiling, coupling, combining and interlocking techniques, designs, systems, routines, devices, manners, modes, fashions, forms, formats, factors, objects, parts, segments, elements, components, constituents, ingredients, processes, methods and combinations entailing, encompassing, comprising, involving, impacting and/or effecting automatizing real-time holistically steady state synchronized ubiquitous continuum real-time rhombus microprocessing instantaneous transmission and receiver transforming traverse conduit aforementioned UCMOST™ real-time processing and/or reprocessing involvine every and all public accounting, transport reconciling, independent auditing and financial reporting inclusive of, without limitation, efficient, effective, functional and integrated streamlined, alternating scale, inseparable, seamless and natural wrapping, interlacing, coiling, coupling, combining and interlocking techniques, designs, systems, routines, devices, manners, modes, fashions, forms, formats, factors, objects, parts, segments, elements, components, constituents, ingredients, processes, methods and combinations entailing, encompassing, comprising, involving, impacting and/or effecting automatizing real-time holistically steady state synchronized ubiquitous continuum real-time rhombus microprocessing instantaneous transmission and receiver transforming traverse conduit aforementioned UCMOST™ real-time processing and/or reprocessing involving every and all order-entry quotation, matching, clearance, execution, settlement and exchange of insurance, risk financing, credit, cash management, investment banking, and PUBLIC FINANCIALS™ instruments basic elemental developments, necessary interactions and integral transactional exchange initiatives, schemes, ocurrences, happenings, interactions, processes, methods, practices, movements, proceedings, messaging, presentations, notifications, filings, submissions, records, activities, actions, events, endeavors, tasks and affairs to swiftly, efficiently and effectively offer a heliocentrical resolution to all of the tremendously long-held and enormously heart-felt unmet needs in the relevant art. Whereas, it is an undeniable and evidentiary findings of fact, documented reference, logical scientific deduction and intuitive analytical reasoning that every and all efficient, perpetual integration of individual members of the aforementioned UNIVERSAL POPULACE™ in every and all basic elemental developments, necessary interactions and integral transactional exchange initiatives, schemes, ocurrences, happenings, interactions, processes, methods, practices, movements, proceedings, messaging, presentations, notifications, filings, submissions, records, activities, actions, events, endeavors, tasks and affairs premised on melioristic logical positivism rubric isomorphic transmuting paradigm shift whose caustic casting aim, letter, nature, breadth, depth, spirit and scope ensures accuracy, quality, timeliness, integrity, honor, relevance, transparency, understandability and comprehensiveness while assuring steadfast adherence and fill compliance to every and all laws, statues, governing rules and authoritative regulations which govern a capital market. The aforementioned UCMOST™ information technologies involve every and all aspects, topics, issues, matters, elements, components, functions, devices, software, systems, methods, combinations, processes and procedures pertaining to and/or involving automatizing real-time holistically steady state synchronized ubiquitous continuous uptime real-time automatizing real-time holistically steady state synchronized ubiquitous continuous uptime real-time automatizing real-time transmission propagating transporting transmuting partible beta particle beam gliding transponder converting receiver conduit aforementioned UCMOST™ real-time processing and/or reprocessing of data and/or information transmission involving every and all aforementioned efficient UNIVERSAL CAPITAL MARKET™ communication propagating the aforementioned efficient UNIVERSAL CAPITAL MARKET™ conceptual aids which heretofore are comprehensively imprudent, generally insolent and broadly unacceptable to concretizing efficient, effective, functional and integrated content management, financial services and aforementioned PUBLIC FINANCIALS™ instruments premised on high-quality streamlined, alternating scale, inseparable, seamless and natural wrapping, interlacing, coiling, coupling, combining and interlocking techniques, designs, systems, routines, devices, manners, modes, fashions, forms, formats, factors, objects, parts, segments, elements, components, constituents, ingredients, processes, methods and combinations involving every and all public accounting, transport reconciling, independent auditing and financial reporting inclusive management, investment banking, and PUBLIC FINANCIALS™ transactional exchange initiatives, schemes, ocurrences, happenings, interactions, processes, methods, practices, movements, proceedings, messaging, presentations, notifications, filings, submissions, records, activities, actions, events, endeavors, tasks and affairs. It is important to understand that the quality, honor and integrity of senior executives which are entrusted to manage the operational, financial and transactional exchange initiatives, schemes, ocurrences, happenings, interactions, processes, methods, practices, movements, proceedings, messaging, presentations, notifications, filings, submissions, records, activities, actions, events, endeavors, tasks and affairs on behalf of the individual members of the aforementioned UNIVERSAL POPULACE™ is the crux of the trust and confidence which individual members of the aforementioned UNIVERSAL POPULACE™ inevitably come to depend on and place their utmost faith in regarding respective expectations, anticipations, hopes, wishes, desires, concerns, uncertainties and fears pertaining to every and all transactional exchange initiatives, schemes, ocurrences, happenings, interactions, processes, methods, practices, movements, proceedings, messaging, presentations, notifications, filings, submissions, records, activities, actions, events, endeavors, tasks and affairs within, throughout and transceding a single holistically econometric marketplace environment. It is furthermore an undeniable and evidentiary findings of fact, documented reference, logical scientific deduction and intuitive analytical reasoning within the heretfore inefficient, ineffective, fragmented and dysfunctional irrationally dynamic and inherently volatile econometric marketplace environment their exist numerous obscure inefficiencies which completely work against enabling full disclosure and compliance with best practices and best executions in every and all aspects, topics, issues, matters, elements, components, functions, devices, software, systems, methods, combinations, processes and procedures pertaining to concretizing efficient, effective, functional and integrated streamlined, alternating scale, inseparable, seamless and natural wrapping, interlacing, coiling, coupling, combining and interlocking techniques, designs, systems, routines, devices, manners, modes, fashions, forms, formats, factors, objects, parts, segments, elements, components, constituents, ingredients, processes, methods and combinations involving every and all public streamlined, alternating scale, inseparable, seamless and natural wrapping, interlacing, coiling, coupling, combining and interlocking techniques, designs, systems, routines, devices, manners, modes, fashions, forms, formats, factors, objects, parts, segments, elements, components, constituents, ingredients, processes, methods and combinations involving order-entry quotation, matching, clearance, execution, settlement and exchange of insurance, risk financing, credit, cash management, investment banking, and PUBLIC FINANCIALS™ instruments transactional exchange initiatives, schemes, ocurrences, happenings, interactions, processes, methods, practices, movements, proceedings, messaging, presentations, notifications, filings, submissions, records, activities, actions, events, endeavors, tasks and affairs within, throughout and transceding a single holistically econometric marketplace environment. These undeniable and evidentiary findings of fact, documented reference, logical scientific deduction and intuitive analytical reasoning undermines the necessary foundation of enhanced fairness, simulteanoues equality, full transparency, consolidated access and perpetual integration to aforementioned PUBLIC FINANCIALS™ statements inclusive of seamlessly and naturally wrapped, twisted, mixed, convoluted, embroidered and combined in connection with aforementioned PUBLIC FINANCIALS™ instruments from members of the aforementioned UNIVERSAL POPULACE™ that necessarily and logically participate with aforementioned fragmenting capital market inefficiencies, and are also tempestuous exponentially detrimental to the cash liquidity, financial solvency and economic stabiilty members of the aforementioned UNIVERSAL POPULACE™ thus inevitably promulgating continued and perpetual harming, damaging, inuring, insistent, insinuating, imposing, pestilent, impetuous, importune, pestiferous, condescending and insolent enthralling, hindering, entrapping, pretending, miring, fatiguing, maleficience, harassing, engulfing, pressing, malevolent, presuming, imprinting, malicious, suffocating, miring, strangling, repressing, entangling, pestering and oppressing individual members of the aforementioned UNIVERSAL POPULACE™ which are traditionally concretizing via inefficient, ineffective, dysfunctional and fragmented vast networks of antiquated, archaic, ancient history and superannuated aforementioned PUBLIC FINANCIALS™ organizations which heretofore continuously, arrogantly, imprudently, irrationally and holistically econometric marketplace environment. Whereas, it is an undeniable and evidentiary findings of fact, documented reference, logical scientific reasoning and intuitive analytical reasoning that every and all of the aforementioned further involve, concern and pertain to every and all members of the aforementioned UNIVERSAL POPULACE™ are necessary and logical participants with aforementioned fragmenting capital market inefficiencies because their treasure accounting, financial fueling and econometric energizing is intrinsically a derivative function of the valuation aforementioned PUBLIC FINANCIALS™ instruments registered, listed and exchanged with aforementioned fragmenting capital market inefficiencies. Thereupon, it is also an undeniable and evidentiary findings of fact, documented reference, logical scientific deduction and intuitive analytical reasoning that enhanced fairness, simulteanoues equality, full transparency, consolidated access and perpetual integration to aforementioned PUBLIC FINANCIALS™ statements and real-time PUBLIC FINANCIALS™ instruments seamlessly and naturally wrapped, twisted, mixed, convoluted, embroidered and combined in connection with aforementioned PUBLIC FINANCIALS™ instruments transactional exchange data and aforementioned PUBLIC FINANCIALS™ instruments transactional exchange information promulgating steadfast adherence and full compliance with every and all laws, statues, governing rules and authoritative regulations of a global marketplace while creating real-time and quality oriented automatizing real-time transmission propagating transporting transmuting partible beta particle beam gliding transponder converting receiver conduit aforementioned UCMOST™ real-time processing and/or reprocessing of data and/or information transmission via every and all mediums of aforementioned efficient UNIVERSAL CAPITAL MARKET™ communication media propagating every and all aforementioned efficient UNIVERSAL CAPITAL MARKET™ conceptual aids which heretofore undeniably, logically, scientifically and intuitively found to be comprehensively imprudent, generally insolent and broadly unacceptable traversing every and all data and/or information content management, financial services and aforementioned PUBLIC FINANCIALS™ instruments transactional exchange initiatives, schemes, ocurrences, happenings, interactions, processes, methods, practices, thereupon enabling assurance of enhanced fairness, simulteanoues equality, full transparency, consolidated access and perpetual integration to every and all basic elemental developments, necessary interactions and integral transactional exchange initiatives, schemes, ocurrences, happenings, interactions, processes, methods, practices, movements, proceedings, messaging, presentations, notifications, filings, submissions, records, activities, actions, events, endeavors, tasks and affairs, which are technically quite easy to embroider, embody and caster into an aforementioned efficient UNIVERSAL CAPITAL MARKET. Whereas, it is an undeniable and evidentiary findings of fact, documented reference, logical scientific deduction and intuitive analytical reasoning that enhanced fairness, simulteanoues equality, full transparency, consolidated access and perpetual integration to aforementioned PUBLIC FINANCIALS™ statements and real-time PUBLIC FINANCIALS™ instruments seamlessly and naturally wrapped, twisted, mixed, convoluted, embroidered and combined in connection with aforementioned PUBLIC FINANCIALS™ instruments transactional exchange data and aforementioned PUBLIC FINANCIALS™ instruments transactional exchange information involves every and all basic elemental developments, necessary interactions and integral transactional exchange initiatives, schemes, ocurrences, happenings, interactions, processes, methods, practices, movements, proceedings, messaging, presentations, notifications, filings, submissions, records, activities, actions, events, endeavors, tasks and affairs, which embody aforementioned fragmenting capital market inefficiencies and the innovative groundbreaking and breakthrough utility engineering and architectural design propagations universal microprocessor computing design provisions of aforementioned UCMOST™ information technology offers members of the aforementioned UNIVERSAL POPULACE™ a unique utility provisional ability to actively and/or passively self-manage their cash liquidity, financial solvency and economy stability in a highly dynamic and integrally global econometric marketplace environmentplace environment. It is further an undeniable and evidentiary findings of fact, documented reference, logical scientific deduction and intuitive analytical reasoning that present aforementioned fragmenting capital market inefficiencies work against formation and establishment of an aforementioned efficient wrapped, twisted, mixed, convoluted, embroidered and combined in connection with aforementioned PUBLIC FINANCIALS™ instruments transactional exchange data with aforementioned PUBLIC FINANCIALS™ instruments transactional exchange information to mitigate and potentially eradicate every and all promulgation of continued and perpetual harming, damaging, inuring, insistent, insinuating, imposing, pestilent, impetuous, importune, pestiferous, condescending and insolent enthralling, hindering, entrapping, pretending, miring, fatiguing, maleficience, harassing, engulfing, pressing, malevolent, presuming, imprinting, malicious, suffocating, miring, strangling, repressing, entangling, pestering and oppressing individual members of the aforementioned UNIVERSAL POPULACE™ which are traditionally concretizing via inefficient, ineffective, dysfunctional and fragmented vast networks of antiquated, archaic, ancient history and superannuated aforementioned PUBLIC FINANCIALS™ organizations which heretofore continuously, arrogantly, imprudently, irrationally and irresponsibly engage in propagating aforementioned fragmenting capital market inefficiencies via the communicating conduits of conceptual aids within a single holistically econometric marketplace environment. Whereas, it is an undeniable and evidentiary findings of fact, documented reference, logical scientific reasoning and intuitive analytical reasoning that every and all of the aforementioned further involve, concern and pertain to every and all basic elemental developments, necessary interactions and integral transactional exchange initiatives, schemes, ocurrences, happenings, interactions, processes, methods, practices, movements, proceedings, messaging, presentations, notifications, filings, submissions, records, activities, actions, events, endeavors, tasks and affairs which are hereto discovered prevalent with aforementioned fragmenting capital market inefficiencies. The aforementioned fragmenting capital market inefficiencies undeniably leads to tempestuous exponentially detrimental and exponential increases in systematic volatitlity and tempestuous exponentially debilitating and exponential increases in the cost of capital of a single holistically econometric marketplace environmentplace environment which negatively overburdens the treasure accounting, financial fueling and econometric energizing members of the aforementioned UNIVERSAL POPULACE™. It is moreover an undeniable and evidentiary findings of fact, documented reference, logical scientific indirectly, in destructive and often irreparable harm and irremeable damage to the value aforementioned PUBLIC FINANCIALS™ instruments registered, listed and exchange by members of the aforementioned UNIVERSAL POPULACE™ with aforementioned fragmenting capital market inefficiencies. It is also an undeniable and evidentiary findings of fact, documented reference, logical scientific deduction and intuitive analytical reasoning that tens of trillions of so-called U.S. dollars inclusive of, without limitaiton, other forms of hard and soft currency values are continuously at stake either directly and/or indirectly via savings and transactional exchanges in monies, currencies, time deposits, escrows, trusts, individual retirements, defined pensions, deferred contributions, social security entitlements, insurance policies, annuity contracts, mutual funds, tracking funds, unit transactional exchange trusts, real estate transactional exchange trusts, closed-end transactional exchanges pools of capital, asset-backed obligations, mortgage-backed obligations, repurchase obligations, collateralized assets, collateralized liabilities, collateralized residual equities, equities, debt, options, futures, forwards, swaps and commodities oriented PUBLIC FINANCIALS™ instruments, along with indexes that track narrow and broad-based basket groups of registered, listed and exchanged aforementioned PUBLIC FINANCIALS™ instruments and/or their derivative composite equivalents. It is further an undeniable and evidentiary findings of fact, documented reference, logical scientific deduction and intuitive analytical reasoning that approximately forty trillion so-called U.S. dollars of the so-called United States of America are consistently subject to instantaneous loss of value as a derivative function of rapid tempestuous devaluation in the per unit price quotation and valuation aforementioned PUBLIC FINANCIALS™ instruments with aforementioned fragmenting capital market inefficiencies, with evidently no common sense, logical basis or justifiable scientific reasoning for every and all such occurrences, and apparently hereto no apparent recourse to members of the aforementioned UNIVERSAL POPULACE™. Without innovative groundbreaking and breakthrough technological advancements and developments composing technological utilty engineering and aesthetic architectural design provisions applicable to every and all methodological procedures and transactional exchange processes of an aforementioned efficient UNIVERSAL CAPITAL not be allowed to prevail, and wherein certainly no forms, parts, means and segements related to optimized and efficient transport flow of real-time public financial statemen and real-time PUBLIC FINANCIALS™ instruments seamlessly and naturally wrapped, twisted, mixed, convoluted, embroidered and combined in connection with aforementioned PUBLIC FINANCIALS™ instruments transactional exchange data and aforementioned PUBLIC FINANCIALS™ instruments transactional exchange information is actualizable with aforementioned fragmenting capital market inefficiencies. The innovation of a high-technological universal interactive digital oriented bridge platform between the general areas of accounting and financing which harnesses and leverages the specialities of public accounting, transport reconciling, independent auditing, communicating, reporting, energizing, fueling, broadcasting, treasuring, distributing and financing, and which is further scalable, fault-tolerant and operates twenty-four hours and day and seven days a week in continuous and perpetual fashion offers real-time connectivity to hundreds of millions members of the aforementioned UNIVERSAL POPULACE™ from around the world.

10. Public Capital Market Auditing

Whereas, it is an undeniable and evidentiary findings of fact, documented reference, logical scientific deduction and intuitive analytical reasoning that whichever respective aforementioned PUBLIC FINANCIALS™ instruments and aforementioned PUBLIC FINANCIALS™ statements from members of the aforementioned UNIVERSAL POPULACE™ whichever every and all are furthermore undeniably, logically, scientifically and intuitively deduced, apprehended and invoked as necessarily integrated, critically important and increasingly integral to individual members of the aforementioned UNIVERSAL POPULACE™ wherefrom invoking the aforementioned UCMOST™ information technology is comprehensively suitable, generally pertinent and broadly useful to intrinsically filing every and all domestic and/or expatriate domain certified real-time periodic, interim and annual Personal Financial Statements (PFS) inclusive of certified payment on income, capital gains and/or other licenses, taxes, rates, stipulated, substantiated, justified, verified, traversed, enacted, levied, imposed, rated, assessed, certified, propagating and subsequent promulgation respectively via legitimate and instrinsically certified hereto members of the aforementioned UNWVERSAL POPULACE™ filing and collection of currency payment of every and all obscurant, irresponsible, feculent, irrational, feckless, disrespectful, mendacious, ignorant, malicious, condescending, untruthful, insolent, inefficient, incognizant, ineffective, fragmenting, unlettered, unpolished, presumptuous, portentous, pretentious, fruitless, disparate, antiquated, archaic, ancient history and superannuated so-called U.S. Department of Treasury (so-called U.S. Treasury), ancient history internal revenue service agency generator scheduled and/or unscheduled Forms and Schedules inclusive of so-called U.S. Treasury Form 1040 in connection with applicable unitermized and basic so-called U.S. Treasury Schedule A, B, and D and/or so-called U.S. Treasury Form 1040EZ from members of the aforementioned UNIVERSAL POPULACE™, inclusive of the more itemized and complex so-called U.S. Treasury Form 1040 in connection with a so-called U.S. Treasury Schedule C, wherefrom further hereto invoked within aforementioned UCMOST™ information technology is comprehensively suitable, generally pertinent and broadly useful to intrinsically certified filing every and all interim so-called U.S. Securities and Exchange Commission (so-called U.S. SEC) processing heretofore via the anciet history Electronic Data Gathering and Automated Retrieval (EDGAR) System wherefrom hereto interim so-called U.S. Form 8-K with a standard fifteen-day time-lagged inabsentia, hardship, inanition, skidding, stalling, hesitant, holding, refusing and restraining unscheduled aforementioned PUBLIC FINANCIALS™ statements, interim so-called U.S. SEC Form 10-Q with a standard forty-five time-lagged inabsentia, hardship, inanition, skidding, stalling, hesitant, holding, refusing and restraining aforementioned PUBLIC FINANCIALS™ statements, interim General Purpose Financial Statements (GPFS) aforementioned PUBLIC FINANCIALS™ statements, interim so-called U.S. SEC Form 10-QSB aforementioned PUBLIC FINANCIALS™ statements from small business registrants, interim so-called U.S. SEC Form SC-13G aforementioned PUBLIC FINANCIALS™ statements filings from beneficial owners, interim so-called U.S. SEC Form SC-13G/A aforementioned PUBLIC comprehensively suitable, generally pertinent and broadly useful to reporting on aforementioned PUBLIC FINANCIALS™ instruments from banking, securities, insurance related public organizations inlcusive of, without limitation, whichever furthermore transactional exchange advisers, transactional exchange companies, foundations, endownments and pension funds wherefrom hereto terminological denominatively part and form members of the aforementioned UNIVERSAL POPULACE™, interim so-called U.S. SEC Form DEF 14-A aforementioned PUBLIC FINANCIALS™ statements comprehensively suitable, generally pertinent and broadly useful to proxy voting from members of the aforementioned UNIVERSAL POPULACE™, interim so-called U.S. SEC Form 497 aforementioned PUBLIC FINANCIALS™ statements comprehensively suitable, generally pertinent and broadly useful to initial filing registration prospectus from transactional exchange company related members of the aforementioned UNIVERSAL POPULACE™, interim so-called U.S. SEC Form 24F-2NT aforementioned PUBLIC FINANCIALS™ statements of registration aforementioned PUBLIC FINANCIALS™ instruments from transactional exchange company related members of the aforementioned UNIVERSAL POPULACE™ interim so-called U.S. SEC Form N-30D aforementioned PUBLIC FINANCIALS™ statements comprehensively suitable, generally pertinent and broadly useful to semi-annual reporting from transactional exchange company related members of the aforementioned UNIVERSAL POPULACE™, initial so-called U.S. SEC Form 3 aforementioned PUBLIC FINANCIALS™ statements comprehensively suitable, generally pertinent and broadly useful to initial filing of directors, officers and persons or public organizations owning more than 10% of any class from members of the aforementioned UNIVERSAL POPULACE™, interim so-called U.S. SEC Form 4 aforementioned PUBLIC FINANCIALS™ statements comprehensively suitable, generally pertinent and broadly useful to filing intention of disolvement of positions from directors, officers and persons and/or public organizations owning more than 10% aforementioned PUBLIC FINANCIALS™ instruments of any class from members of the aforementioned UNIVERSAL POPULACE™, wherefrom further hereto annual so-called U.S. SEC Form 10-K with a standard ninety-day time-lagged inabsentia, hardship, (CAFR) aforementioned PUBLIC FINANCIALS™ statements, annual so-called U.S. SEC Form 20-F aforementioned PUBLIC FINANCIALS™ statements and/or annual so-called U.S. SEC Form 5 aforementioned PUBLIC FINANCIALS™ statements respectively from domestic, foreign registrants and/or directors, officers and persons and/or public organizations owning more than 10% aforementioned PUBLIC FINANCIALS™ instruments of any class from members of the aforementioned UNIVERSAL POPULACE™ in combination with the aforementioned PUBLIC FINANCIALS™ instruments to effectuate management decisions regarding the operating performance, transactional exchange and financial profitability members of the aforementioned UNIVERSAL POPULACE™, wherefrom hereto evidently deriving, inducing and invoking further terminological denominative of every and all aforementioned PUBLIC FINANCIALS™ instruments as comprehensively suitable, generally pertinent and broadly useful via streamlined, alternating scale, inseparable, seamless and natural wrapping, interlacing, coiling, coupling, combining and interlocking within every and all aforementioned PUBLIC FINANCIALS™ statements traversing inclusive of, without limitation, every and all other industries and sectors in a single holistically econometric marketplace environment beyond the following specified multifaceted industries and multidimensional sectors entailing, encompassing, comprising, involving, impacting and/or effecting banking, securities and insurance, wherefrom hereto it is clearly an undeniable and evidentiary findings of fact, documented reference, logical scientific deduction and intuitive analytical reasoning that every and all of the interim aforementioned PUBLIC FINANCIALS™ statements from either members of the aforementioned UNIVERSAL POPULACE™ nor members of the aforementioned UNIVERSAL POPULACE™ are independently audited for the benefit of an aforementioned efficient UNIVERSAL CAPITAL MARKET™. It is ironic that in today's world of exponentially increasing artificial satellite, wire jack line and wire-less communication capabilities, hardware manufacture computing capacity and software program and operating systems innovations involving varying techniques, designs, systems, routines, devices, manners, modes, fashions, forms, formats, factors, objects, parts, segments, elements, components, constituents, ingredients, processes, methods and increased level of trust and confidence within an aforementioned efficient UNIVERSAL CAPITAL MARKET™ by affording continuous real-time independent computer driven public auditing of the public finanical statements with PUBLIC FINANCIALS™ instruments members of the aforementioned UNIVERSAL POPULACE™ for the benefit members of the aforementioned UNIVERSAL POPULACE™ to scurtinze the accuracy, quality, integrity, honor, timeliness, relevance, transparency, reliabilty, verifiability, comprehensiveness, understandability and assurance of every and all real-time processing and/or reprocessing of data and/or information receiver which entails the utlization of the assets members of the aforementioned UNIVERSAL POPULACE™ inclusive of their capacities to meet their obligatory liabilities in an effort to promulgate residual equities via concretizing performance and expenditure related industry and sector driven measured benchmarks. It is also clearly an undeniable and evidentiary findings of fact, documented reference, logical scientific deduction and intuitive analytical reasoning that if the interim 10-Q and GPFS aforementioned PUBLIC FINANCIALS™ statements inclusive of seamlessly and naturally wrapped, twisted, mixed, convoluted, embroidered and combined in connection with aforementioned PUBLIC FINANCIALS™ instruments were independently audited interim of quarterly and annual audits it would inevitably instill a higher degree of integrity, quality and assurance pertaining to the accuracy, quality, integrity, honor, timeliness, relevance, transparency, reliabilty, verifiability, comprehensiveness, understandability and assurance of every and all real-time processing and/or reprocessing of data and/or information receiver from members of the aforementioned UNIVERSAL POPULACE™ thus increasing the trust and confidence members of the aforementioned UNIVERSAL POPULACE™ in the senior executives entrusted to manage and administer the operational, financial and transactional exchange transactional driven interchange and exchange of varying techniques, designs, systems, routines, devices, manners, modes, fashions, forms, formats, factors, objects, parts, segments, elements, components, constituents, ingredients, processes, methods and combinations of commercial oriented initiatives, schemes, ocurrences, happenings, interactions, processes, methods, practices, movements, proceedings, messaging, presentations, notifications, filings, submissions, records, activities, actions, events, aforementioned fragmenting capital market inefficiencies, and thereupon within the aforementioned efficient UNIVERSAL ECONOMY™.It is also an undeniable and evidentiary findings of fact, documented reference, logical scientific deduction and intuitive analytical reasoning that present the highest degree of assurance afforded to members of the aforementioned UNIVERSAL POPULACE™ with respect to the specialty area of public auditing is that aforementioned PUBLIC FINANCIALS™ statements inclusive of seamlessly and naturally wrapped, twisted, mixed, convoluted, embroidered and combined in connection with aforementioned PUBLIC FINANCIALS™ instruments are strictly audited on an annual basis pertaning to an independent public audit which seeks to scrutinize the accuracy, relevance, transparency, comprehensiveness and understandability aforementioned PUBLIC FINANCIALS™ statements inclusive of seamlessly and naturally wrapped, twisted, mixed, convoluted, embroidered and combined in connection with aforementioned PUBLIC FINANCIALS™ instruments while ensuring that every and all real-time processing and/or reprocessing of data and/or information receiver is properly retrieved, converted, formatted, processed, stored, gathered, compiled, tabulated, prepared, presented, submitted, validated, verified, confirmed, broadcast, distributed and syndicated respectively to the so-called U.S. SEC or the applicable governing bodies and/or regulatory authorities in accordance with transnational generally accepted public auditing principles and standards. Therewithal, it is also an undeniable and evidentiary findings of fact, documented reference, logical scientific deduction and intuitive analytical reasoning that the annual independent public audit aforementioned PUBLIC FINANCIALS™ statements inclusive of seamlessly and naturally wrapped, twisted, mixed, convoluted, embroidered and combined in connection with aforementioned PUBLIC FINANCIALS™ instruments from public/private organizations referred to as 10-Ks which are heretofore filed with the so-called U.S. SEC, and the annual independent public audit aforementioned PUBLIC FINANCIALS™ statements inclusive of seamlessly and naturally wrapped, twisted, mixed, convoluted, embroidered and combined in connection with aforementioned PUBLIC FINANCIALS™ instruments from government entities and not-for-profit organizations referred to as Comprehensive and/or applicable governing bodies and/or regulatory authorities with an undeniable, unnecessary, unwarranted, illogical, unjustifiable, unreasoned and unmitigated standard ninety-day time-lagged hestiant, holding and restraining delay. Moreover, it is clearly an undeniable and evidentiary findings of facts, documented reference, logical scientific deduction reasoning that independent public auditing mechanisms are essential to ensure that principles and standards inclusive of best practices in independent public auditing are effectively applied and maintained, and further to monitor the accuracy, quality, integrity, honor, timeliness, relevance, transparency, reliabilty, verifiability, comprehensiveness, understandability and assurance of internal controls and independent external control procedures of every and all transactional exchange of data, information and public aforementioned PUBLIC FINANCIALS™ instruments financial invetment instrument between members of the aforementioned UNIVERSAL POPULACE™, wherein both internal audits and independent external public audits are necessary and beneficial. It is clearly evident that with the onset of the information age which embodies the new milennium involving exponentially increasing coupling and combinatorial aspects, topics, elements, components, issues and matters of artificial satellite, wire jack line and wireless communication capabilities, hardware manufacture computing capacity and software program and operating systems innovations involving varying techniques, designs, systems, routines, devices, manners, modes, fashions, forms, formats, factors, objects, parts, segments, elements, components, constituents, ingredients, processes, methods and combinations of information technology every and all transactional software programs, computing systems, business methods, computing processes and combinatorial procedures in the new milennium which embody the essence of the information age milennium must be capable of ensuring accuracy, quality, integrity, honor, timeliness, relevance, transparency, reliabilty, verifiability, comprehensiveness, understandability and assurance of every and all real-time processing and/or reprocessing of data and/or information receiver from members of the aforementioned UNIVERSAL POPULACE™ pertaining to their respective PUBLIC FINANCIALS™ statements with PUBLIC FINANCIALS™ instruments, Furthermore, every and all transactional software programs, computing systems, business methods, computing processes and combinatorial independent audits aforementioned PUBLIC FINANCIALS™ statements inclusive of seamlessly and naturally wrapped, twisted, mixed, convoluted, embroidered and combined in connection with aforementioned PUBLIC FINANCIALS™ instruments in accordance with transnational generally accepted public auditing principles, standards and best practices, and thereupon ensure that every and all real-time processing and/or reprocessing of data and/or information receiver is furthermore properly retrieved, processed, stored, gathered, compiled, tabulated, prepared, presented, broadcast, distributed and syndicated on worldwide scale premised on offering enhanced fairness, simulteanoues equality, full transparency, consolidated access and perpetual integration in the form of display aforementioned PUBLIC FINANCIALS™ statements and real-time PUBLIC FINANCIALS™ instruments to assist members of the aforementioned UNIVERSAL POPULACE™ in seamlessly and naturaly effectuating efficient, effective, streamlined, objective, well-informed, risk-managed and self-assured aforementioned PUBLIC FINANCIALS™ instruments transactional exchange decision initiatives, schemes, ocurrences, happenings, interactions, processes, methods, practices, movements, proceedings, messaging, presentations, notifications, filings, submissions, records, activities, actions, events, endeavors, tasks and affairs to thereupon further offer them utility products and services which concretize a seamless and perpetual capacity to protect, sustain and expand their treasure accounting, financial fueling and econometric energizing in a highly dynamic and inherently volatile, fragile, frigid and ruthless global marketplace. Therefore, every and all techniques, designs, systems, routines, devices, manners, modes, fashions, forms, formats, factors, objects, parts, segments, elements, components, constituents, ingredients, processes, methods and combinations pertaining to the formation and establishment of an aforementioned efficient UNIVERSAL CAPITAL MARKET™ must be conceived, engineered, designed and developed via contructive reduction to practice on the exclusive premise of full disclosure, best practices, best executions, enhanced fairness, simultaneous equality, full transparency, consolidated access and perpetual integration of members members of the aforementioned UNIVERSAL POPULACE™, involving every and all real-time and perpetual independent computing driven public auditing of every and all real-time processing twisted, mixed, convoluted, embroidered and combined in connection with aforementioned PUBLIC FINANCIALS™ instruments from members of the aforementioned UNTVERSAL POPULACE™, tailord to offering members of the aforementioned UNIVERSAL POPULACE™ full disclosure, best practices, best executions, enhanced fairness, simulteanoues equality, full transparency, consolidated access and perpetual integration to new and higher standards of real-time optimized and efficient transport flow of holistically steady state continuous spectrum ubiquitous indistinguishably synchronous needs involving aforementioned UCMOST™ real-time processing and/or reprocessing of data and/or information content management, financial services and aforementioned PUBLIC FINANCIALS™ instruments transactional exchange initiatives, schemes, ocurrences, happenings, interactions, processes, methods, practices, movements, proceedings, messaging, presentations, notifications, filings, submissions, records, activities, actions, events, endeavors, tasks and affairs involving every and all basic elemental developments, necessary interactions and integral transactional exchange initiatives, schemes, ocurrences, happenings, interactions, processes, methods, practices, movements, proceedings, messaging, presentations, notifications, filings, submissions, records, activities, actions, events, endeavors, tasks and affairs within the aforementioned ancient history UNIVERSAL CAPITAL MARKET™. Whereas, it is an undeniable and evidentiary findings of fact, documented reference, logical scientific deduction and intuitive analytical reasoning, logical scientific deduction reasoning that in August of 1998, the largest five present public accounting and public auditing practices in the world, heretofore widely recognized and acknowledged as the Big Five, found it useful to unite their research and development efforts via a Big Five Audit Materiality Task Force (hereafter, the Big Five Public Audit Task Force); thereupon the Big Five Public Audit Task Force submitted a status report to the American Institute of Certified Public Accountants (so-called AICPA) for review and analysis, whereupon delivering its initial recommendations which were deemed comprehensively suitable, generally pertinent and broadly useful to the aim, letter, nature, breadth, depth, spirit and scope of the field of independent public auditing to the so-called U.S. SEC which had originally suggested the unified report premised on issues raised in its findings fragmenting capital market inefficiencies. The mission of the Big Five Public Audit Task Force was to identify, research and draw conclusions on aspects, topics, elements, components, issues and matters that have emerged relating to audit materiality and the impact that software program and operating systems enabled information technology were going to have onaforementioned PUBLIC FINANCIALS™ statements inclusive of seamlessly and naturally wrapped, twisted, mixed, convoluted, embroidered and combined in connection with aforementioned PUBLIC FINANCIALS™ instruments pertaining to the previous notions of the efficient, effective, functional and integrated streamlined, alternating scale, inseparable, seamless and natural wrapping, interlacing, coiling, coupling, combining and interlocking techniques, designs, systems, routines, devices, manners, modes, fashions, forms, formats, factors, objects, parts, segments, elements, components, constituents, ingredients, processes, methods and combinations of public accounting, transport reconciling, independent auditing and financial reporting principles, standards, interpretations and practices in the future. The so-called U.S. SEC in its findings evinced and subsequently raised two specific concerns, (i) whether there is a need to re-evaluate the effects aforementioned PUBLIC FINANCIALS™ statements inclusive of seamlessly and naturally wrapped, twisted, mixed, convoluted, embroidered and combined in connection with aforementioned PUBLIC FINANCIALS™ instruments misstatements identified in an audit more rigorously in light of the tempestuous exponentially detrimental increases in systematic volatility and tempestuous exponentially debilitating increases in the costs of capital with aforementioned fragmenting capital market inefficiencies evinced in recent years, and (ii) whether too much independent auditor tolerance exists for misstatements inaforementioned PUBLIC FINANCIALS™ statements inclusive of seamlessly and naturally wrapped, twisted, mixed, convoluted, embroidered and combined in connection with aforementioned PUBLIC FINANCIALS™ instruments that are intentionally made by senior executives members of the aforementioned UNIVERSAL POPULACE™ to self-manage their organizational earnings, performance and profitability within the aforementioned fragmenting capital market inefficiencies. In both cases, the so-called U.S. SEC staff observed that audit materiality thresholds might need to be reexamined. The Big Five aforementioned UNIVERSAL POPULACE™ to other members of the aforementioned UNIVERSAL POPULACE™ appeared realizable given necessary artificial satellite wireless and wired communications infrastructure capabilities, hardware manufacture computing capabilities, and software program and operating systems enabled information technology, but that is was emphatic about its inability to understand or forecast the dramatic shifts which would eventually concretize as the world entered the new milennium. The Big Five Public Audit Task Force concluded that every and all aforementioned PUBLIC FINANCIALS™ statements inclusive of seamlessly and naturally wrapped, twisted, mixed, convoluted, embroidered and combined in connection with aforementioned PUBLIC FINANCIALS™ instruments might soon be considered material under the notion of public accounting, independent auditing, and financial reporting principles, standards, interpretations, and practices concerning operational, financial and transactional exchange initiatives, schemes, ocurrences, happenings, interactions, processes, methods, practices, movements, proceedings, messaging, presentations, notifications, filings, submissions, records, activities, actions, events, endeavors, tasks and affairs particularly regarding how every and all real-time processing and/or reprocessing of data and/or information receiver would be retrieved, converted, formatted, processed, stored, gathered, compiled, tabulated, prepared, presented, submitted, validated, verified, confirmed, broadcast, distributed and syndicated respectively to the so-called U.S. SEC or the applicable governing bodies and/or regulatory authorities. The Big Five Public Audit Task Force also concluded that it is completely possible, in a world where everything is considered material, to present continual assurances to the audit committee, board of directors, internal auditors, governing members, independent auditors, securities analysts and more importantly, members of the aforementioned UNIVERSAL POPULACE™ especially given the developments toward integrating the worldwide economies wherein transnational generally accepted public accounting and public auditing principles, standards, interpretations and practices would certainly enter the forefront of every and all such areas of practice are comprehensively suitable, generally pertinent and broadly useful to their specialty area of public accounting and pulbic auditing. Furthermore, it is clearly an concerned about the findings it has evinced elsewhere in an effort to promulgate widespread reform in public accounting and public auditing, because within an article published within the so-called Commodities Regulation Law Journal dated May 19, 2000, reported that recent U.S. SEC concerns with so-called Wall Street and the so-called Big Five public accounting and public auditing professional limited liability practices had to do with the apparent deterioration in public accounting, independent auditing and financial reporting, and more specifically, the role of the profession in adhering to and complying with the high degree of accuracy, quality, integrity, honor, timeliness, relevance, transparency, reliabilty, verifiability, comprehensiveness, understandability and assurance which naturally must inevitably form the premise upon which aforementioned PUBLIC FINANCIALS™ statements are concretized. Wherefrom hereafter every and all aforementioned PUBLIC FINANCIALS™ statements are seamlessly and naturally wrapped, twisted, mixed, convoluted, embroidered and combined in connection with aforementioned PUBLIC FINANCIALS™ instruments to thereupon be disseminated to individual members of the aforementioned UNIVERSAL POPULACE™ in via real-time aforementioned PUBLIC FINANCIALS™ conceptual aids traversed via real-time aforementioned aforementioned PUBLIC FINANCIALS™ communications to mitigate every and all aforementioned fragmenting capital market inefficiencies and thereupon facilitate formation of a new theater of operations and higher standards for a seamlessly and naturalll wrapped, twisted, mixed, convoluted, coupled and combined aforementioned efficient UNIVERSAL CAPITAL MARKET™ for a necessarily integrated and increasingly integral aforementioned efficient UNIVERSAL ECONOMY™. The article published in within the Commodities Regulation Law Journal went on to describle that the apparent sudden so-called U.S. SEC interest in the traditionally distinctive and mutually exclusive disaparate and fragmented public accounting industry, public finanical reporting industry and the independent public audit industry is not a recent phenomena as it pertained to the concerns and issues raised about the accuracy, quality, integrity, honor, timeliness, relevance, transparency, reliabilty, verifiability, comprehensiveness, understandability and assurance of financial reporting utilized by senior executives, therein reflecting the so-called U.S. SEC's increasing aforementioned UNIVERSAL POPULACE™ within the aforementioned fragmenting capital market inefficiencies. The so-called U.S. SEC has been concerned for some time that the valuations of public aforementioned PUBLIC FINANCIALS™ instruments financial transactional exchange instrumnets in so-called U.S. capital market is illogically extremely sensitive to the slightest shortfall in finacial reporting of earnings, performance and profitability, and the enormous disparity which exists from the anticipated and concretizing per share earnings reports of these members of the aforementioned UNIVERSAL POPULACE™ filed on a time-lagged interim, quarterly and annual basis. The so-called U.S. SEC reportedly feels that speculative estimates, present so-called whisper numbers, as inefficiently and inappropriately surveyed by so-called Wall Street securities analysts and parasitic registered representatives within the aforementioned fragmenting capital market inefficiencies propagating and promulgate continued and perpetual harming, damaging, inuring, insistent, insinuating, imposing, pestilent, impetuous, importune, pestiferous, condescending and insolent enthralling, hindering, entrapping, pretending, miring, fatiguing, maleficience, harassing, engulfing, pressing, malevolent, presuming, imprinting, malicious, suffocating, miring, strangling, repressing, entangling, pestering and oppressing individual members of the aforementioned UNIVERSAL POPULACE™ which are traditionally concretizing via inefficient, ineffective, dysfunctional and fragmented vast networks of antiquated, archaic, ancient history and superannuated aforementioned PUBLIC FINANCIALS™ organizations which heretofore continuously, arrogantly, imprudently, irrationally and irresponsibly engage in propagating aforementioned fragmenting capital market inefficiencies via the communicating conduits of conceptual aids within a single holistically econometric marketplace environment. For instance, with respect to the involvement of heretofore so-called public accounting, so-called independent auditing and so-called financial reporting from the Big Five aforementioned PUBLIC FINANCIALS organizations it is reported in an article published within the Miami Herald dated May 2, 2001 that the so-called limited liability practice which oversaw the public accounting, transport reconciliation, independent auditing and financial reporting for the so-called above aforementioned world-Leading promotional marketing and franchise company with ownership rights to mortgage/agency services which was formed in December 1997 with the onset of a merger between two regional albeit heretofore world-class aforementioned PUBLIC FINANCIALS™ organizations within their respective industries and sectors; whareas wherefrom in an article published in the Miami Herald business section dated Dec. 10, 1999, it was reported that subsequent to effectuating purchases of the merged public organization's registered, listed and exchanged PUBLIC FINANCIALS™ instruments, plaintiffs eventually found themselves in court with the merged public organization claiming that a major division of a segment part of the merged public organization had previously engaged in practicing (i) accounting irregularities are comprehensively suitable, generally pertinent and broadly useful to the overbooking, or booking in advance, of revenues in one of the discount membership subscription operations, leading to a one-time US$500 million restatement of the PUBLIC FINANCIALS™ statements of the merged public organization are comprehensively suitable, generally pertinent and broadly useful to the previously disseminated earnings profitability of the merged public organization which had been filed for submission for the previous three years pertaining to the year-ending 1995-1997; whereas moreoever, the pertinent legal proceedings, plaintiffs also accused the merged public organization of disclosing (ii) false and misleading information, (iii) failure to disclose material information, and (iv) allowing directors and executive officers to sell stock equity shares of the merged public organization before announcing and/or disseminating the accounting irregularities to individual members of the aforementioned UNIVERSAL POPULACE™, which inevitably concretizing allegations of insider trading within the aforementioned PUBLIC FINANCIALS™ instruments of the merged public organization by senior executives involved in the fraudulent schemes to manage the earnings of the public organization evincing a US$14.5 billion loss in valuation with no recourse to aforementioned members of the UNIVERSAL POPULACE™ holding participating equity positions in the merged public organizaation concretizing a wide-spread financial disaster followed by ridiculous disbelief at major, extremely prominent, widely recognized and well-established traditional banking, securities and insurance oriented members of the aforementioned UNIVERSAL POPULACE™ and their subsidiary branches and sales commissioned false and misleading financial information; whereas creating one of the most dramatic and sustained financial losses in the market valuation of aforementioned PUBLIC FTNANCIALS™ instrument registered, listed and exchanged by within the aforementioned fragmenting capital market inefficiencies during all of 1998, wherefrom actualizing a completely unacceptable and unequivocally intolerable findings that hundreds of millions of individual members of the aforementioned UNIVERSAL POPULACE™ were, directly and/or indirectly, subjected to an overnight loss of approximately US$14.5 billion in capital market value involving the aforementioned PUBLIC FINANCIALS™ instruments, and wherefrom an article published in the Miami Herald dated Mar. 1, 2001, reported that the so-called U.S. SEC has filed a civil enforcement action against the two former highest ranking senior executive officers for falsely inflating the value of a segment part of the direct marketing organization which sold memberships in discount buying clubs which became a part and form of the eventually merged public organization devised in December 1997 for having evidently engaged in fraudulent account manipulation pertaining to directing a financial fraud scheme comprising overstating the revenues of the organization which eventually became a part and form of the merged public organization by US$500 million between 1995 and 1997, and wherefrom the so-called U.S. SEC seeks that the two former senior executives to forfeit every and all stock gains which they may have accumulted from the time of ther merger inclusive of, without limitation, paying additional penalties, and whereas it was further reported that three other former lower-level albeit high-ranking senior executive officers of the organization which eventually became a part and form of the merged organization already pleaded guilty in the accounting and financial fraud scandal operating income for 1997 by as much as US$170 million realizing a sigle day US$14.5 billion loss in the value of the aforementioned PUBLIC FINANCIALS™ instruments of the so-called merged organzation in what eventually became a major capital market scandal with world-wide reprecussion, and furthermore intrinsically evinced the largest financial fraud case ever pursued and prosecuted by the so-called U.S. SEC, conclusive evincing of a record US$2.83 billion settlement of a class-action shareholder lawsuit against the merged organization and its two former highest ranking so-called Big Five aforementioned PUBLIC FINANCIALS organization agreed to settle for US$335 million civil charges related to certifying the aforementioned PUBLIC FINANCIALS™ statements; whereas it is evinced that another one of the limited liabilty practice so-called Big Five aforementioned PUBLIC FINANCIALS organizations also lied and misled members of the aforementioned UNIVERSAL POPULACE with respect to an aforementioned unrelated 1997 case involving a heretofore world-class appliance manufacturing aforementioned PUBLIC FINANCIALS organization, the limited liability practice so-called Big Five aforementioned PUBLIC FINANCIALS organization knowingly and recklessly disregarded multitudes of occurences, happenings, happenstance and transpiring which evinced that internal controls within the so-called world-lcass appliance manufacturing aforementioned PUBLIC FINANCIALS organization were completely and unequivocally non-existent in mission critical areas and that numerous factors constituting financial data were inaccurate and unreliable, all of which notwithstanding to the limited liability practice so-called Big Five aforementioned PUBLIC FINANCIALS organization which negligently failed to properly and prudently uphold the duties of an independent audit during 1997, and therewithal fraudulently certified the heretofore so-called aforementioned PUBLIC FINANCIAL statements during 1997 and through the year-ending 1998; whereas it is evinced in the May 2, 2001 business section article within the Miami Herald that this other limited liability practice member of the so-called Big Five aforementioned PUBLIC FINANCIALS organization has now agreed to settle for US$110 million civil charges related to certifying the aforementioned PUBLIC FINANCIALS™ statements. Therefrom, it is an undeniable and evidentiary findings of fact, documented reference, logical scientific reasoning and intuitive analytical reasoning that every and all of the aforementioned further involve, concern and pertain to every and all assets, liabilities, and residual equities from members of the aforementioned PUBLIC FINANCIALS™ organization, inclusive of, without limitation, their performance and profitiability in deploying every and all available operating, financial and transactional exchange related economic resources entrusted to them with a capital market which theoretically, legally, undeniably, logically, scientifically and intuitively belong entirely and exclusively to concerns, issues and matters concerning accounting, pursuing, reviewing, prosecuting and reporting these major incidents and/or unnecessary instances in accordance with the premised of U.S. Securities Act and the U.S. Securities Exchange Act, the so-called U.S. SEC heretofore lackadaisically has reportedly increasingly felt that logically every and all of these techniques, designs, systems, routines, devices, manners, modes, fashions, forms, formats, factors, objects, parts, segments, elements, components, constituents, ingredients, processes, methods and combinations of utilizing time-lagged and dated PUBLIC FINANCIALS™ statements and time-lagged and dated PUBLIC FINANCIALS™ instruments premised on these inefficiently and inappropriately surveyed guesses from a limited number of securities analysts, who should not, by law, be privy to such data and information prior to the equal and simultaneous dissemination of the concretizing filings of public accounting, independent auditing and financial reporting within the heretofore capital market itself a propagation by the U.S. SEC, directly and indirectly, inclusive of, without limitation all of the limited liability practice so-called Big Five aforementioned PUBLIC FINANCIALS organizations, and the members of the vast network of so-called banking, so-called securities and so-called insurance aforementioned PUBLIC FINANCIALS organizations which heretofore so-called bank roll public organizations, wherefrom and whereupon via every and all aforementioned so-called conceptual aids and aforementioned so-called communications promulgate continued and perpetual traditional establishment and entrenchment of the aforementioned fragmenting capital market inefficiencies. It is now being more apparent to the so-called U.S. SEC that when a public organization fails to meet these speculative earnings on a quarterly and annual basis, the public organization suffers an immediate loss in the valuation of its PUBLIC FINANCIALS™ instruments, which logically directly and indirectly concretizes enormous losses to the treasure accounting, financial fueling and econometric energizing members of the aforementioned UNIVERSAL POPULACE™ . Whereas, it is an undeniable and evidentiaty findings of fact, documented reference, logical scientific deduction and intuitive analytical reasoning that appart from the recently enacted Regulation Fair Disclosure to emphatically limit every and all techniques, designs, systems, routines, devices, manners, modes, fashions, forms, selectively within the aforementioned fragmenting capital market inefficiencies, the various laws embodying the Foreign Corrupt Practices Act of 1970, Transactional exchange Advisors Act of 1970, the Transactional exchange Company Act of 1940, the so-called U.S. Securities Exchange Act of 1934 and the so-called U.S. Securities Act of 1933 clearly dictated that every and all techniques, designs, systems, routines, devices, manners, modes, fashions, forms, formats, factors, objects, parts, segments, elements, components, constituents, ingredients, processes, methods and combinations of initiative; schemes, ocurrences, happenings, interactions, processes, methods, practices, movements, proceedings, messaging, presentations, notifications, filings, submissions, records, activities, actions, events, endeavors, tasks and affairs that propagating and/or promulgate continued and perpetual harming, damaging, inuring, insistent, insinuating, imposing, pestilent, impetuous, importune, pestiferous, condescending and insolent enthralling, hindering, entrapping, pretending, miring, fatiguing, maleficience, harassing, engulfing, pressing, malevolent, presuming, imprinting, malicious, suffocating, miring, strangling, repressing, entangling, pestering and oppressing individual members of the aforementioned UNIVERSAL POPULACE™ which are traditionally concretizing via inefficient, ineffective, dysfunctional and fragmented vast networks of antiquated, archaic, ancient history and superannuated aforementioned PUBLIC FINANCIALS™ organizations which heretofore continuously, arrogantly, imprudently, irrationally and irresponsibly engage in propagating aforementioned fragmenting capital market inefficiencies via the communicating conduits of conceptual aids within a single holistically econometric marketplace environment. Whereas, it is an undeniable and evidentiary findings of fact, documented reference, logical scientific reasoning and intuitive analytical reasoning that every and all of the aforementioned further involve, concern and pertain to every and all undeniably lead to tempestuous exponentially detrimental increases in the systematic volatility and tempestuous exponentially debilitating increases in the cost of capital propagated via the aforementioned fragmenting capital market inefficiencies are unequivocally illegal in any and all aim, letter, nature, breadth, depth, spirit and scope. Moreover, on Sep. 28, 1998, the so-called U.S. SEC announced its original request to form a blue ribbon committee vast multituides of the aforementioned fragmenting capital market inefficiencies,. The blue ribbon committee drew panelists from the various member constituencies of the community aforementioned PUBLIC FINANCIALS™ instruments, which logically pertains to every and all of the basic elemental developments, necessary interactions and integral transactional exchange initiatives, schemes, ocurrences, happenings, interactions, processes, methods, practices, movements, proceedings, messaging, presentations, notifications, filings, submissions, records, activities, actions, events, endeavors, tasks and affairs within the aforementioned fragmenting capital market inefficiencies involving the distinctively separate and traditonally exclusive specialty areas of public accounting, transport reconciling, independent auditing and financial reporting inclusive of order-entry quotation, matching, clearance, execution, settlement and exchange of insurance, risk financing, credit, cash mangement, transactional exchange banking and PUBLIC FINANCIALS™ instruments. The so-called U.S. SEC endeavors with the blue ribbond committee was to promulgate recommendations on strengthening the role of auditing committees in supervising the financial reporting members of the aforementioned UNIVERSAL POPULACE™. The studies conducted and actions recommended by the blue ribbon committee were made in response to recent concerns expressed by the so-called U.S. SEC Chairman Arthur Levitt pertaining to the tempestuous diminished adequacy in oversight of the audit process by independent auditors in recent years as evinced in the evidentiary auditor tolerance for manipulations of earnings, improper utilization of asset reserves and other forms of anticpated manipulation of revenues to deceive participants within the aforementioned fragmenting capital market inefficiencies. The panel of the blue ribbon recommended subtle changes to listing standard with respect to the role and composition of auditing committees, important changes to auditing standards concerning how auditors and audit committees interact, adjusted public disclosure requirements, and a formulation of best practices involving transnational public auditing pirnciples, standards and best practices applicable to the aforementioned fragmenting capital market inefficiencies. The blue ribbon committee report was geared toward effecting pragmatic and progressive changes in the functions and expectations placed on corporate boards, audit committees, senior financial management, internal UNIVERSAL POPULACE™. The blue ribbon committee formed the panel of member constituencies in an effort to become more understanding of the interactions between these market forces while considering the concerns and opinioins of relevant market participants. The blue ribbon committees ultimate strive was to produce recommendations that promote quality financial reporting, recognize the benefits that would be gained in market confidence, the numerous efficiencies generated in the allocation of capital, and moreover the resulting lower cost of capital which greater efficiencies within an aforementioned efficient UNIVERSAL CAPITAL MARKET™ logically evince. It was a noteworthy accomplishment of the blue ribbon committee to formulate a policy wherein higher levels of disclosure requirements enable audit committee members to infrom members of the aforementioned UNIVERSAL POPULACE™ of signed acknowledgements regarding lack of board independence inmembers of the aforementioned UNIVERSAL POPULACE™. Whereas, the so-called AICPA formed a special committee on so-called assurance services approximately three years ago to identify and address the need to reexamine the threshold of materiality in audits, and the tolerance by auditors of intentional misstatements of PUBLIC FINANCIALS™ statements by senior executives members of the aforementioned UNIVERSAL POPULACE™ in an effort to inappropriately manage earnings by improperly leverage asset reserves. The so-called AICPA special committee reported the findings of its two-year research and deliberation endeavors and recently presented its recommendations to its approximately 330,000 member certified public accountants and certified public auditors by posting and displaying its results on its authenticated web-site (www.aicpa.org). The special committees report concluded that market forces in the industry profession of public accounting and public auditing are beginning to shift focus to meeting the needs members of the aforementioned UNIVERSAL POPULACE™ wherein it essentially acknowledged that openness in disclosure aforementioned PUBLIC FINANCIALS™ statements inclusive of seamlessly and naturally wrapped, twisted, mixed, convoluted, embroidered and combined in connection with aforementioned PUBLIC FINANCIALS™ instruments may be an inevitable outcome in the information age of the twenty-first century. Generally speaking, the special committees two-year audit of historical PUBLIC FINANCIALS™ statementss, changing laws, statues, governing rules and authoritative regulations, the importance of the role and impact that information technology would eventually have on the public accounting and public auditing professions. The so-called AICPA special committee evidently believes several megatrends will change the global marketplace over the next ten years, wherein there will inevitably be consequences for the economic and professional functions of certified public accountants and certified public audiors. In summary, the special committee reported that information technology is to serve the greatest impact on the role of the public accounting and public auditing profession in the years to come with an accelerating shift in power from members of the aforementioned UNIVERSAL POPULACE™ or producers of merchandising products, goods, supplies and services to members of the aforementioned UNIVERSAL POPULACE™ or consumers of merchandising products, goods, supplies and services. Whereas, it is an undeniable and evidentiary findings of facts, documented reference and evidently logical scientific deduction reasoning that the so-called AICPA special committee reported it believes consumers inclusive of, without limitation, internal and external users of public every and all real-time processing and/or reprocessing of data and/or information receiver, will eventually communicative with one another to identify and address their common or uncommon views while expressing them jointly with the aid of information technology whereinmembers of the aforementioned UNIVERSAL POPULACE™ or producers of merchandising products, goods, supplies and services will inevitably learn from the preferential interests of consumers in an effort to align the interests of both parties to a higher level of degree than has ever been possible in the history of a single holistically econometric marketplace environment. The so-called AICPA special committee believes many challenges will inevitably arise as the need to assure members of the aforementioned UNIVERSAL POPULACE™ are comprehensively suitable, generally pertinent and broadly useful to the accuracy, authentication, privacy and trust involved in this newly developing digital oriented global marketplace. The so-called AICPA special committee believes new technologies, marketplace competition, changes in staff personnel relations and unknow and unforeseen attempts at controlling risk will forms, formats, factors, objects, parts, segments, elements, components, constituents, ingredients, processes, methods and combinations are comprehensively suitable, generally pertinent and broadly useful to the global marketplace. The so-called AICPA special committee believes these long-term trends will eventually affect information flows creating difficult public accounting problems which need to be addressed such as the applicability of the legal entity concept, difficulties in quantifying and measuring performance and accounting profitability, varying interpretations of the going-concern assumptions, and a tempestuous diminishing role of the concept of arms-length competitive oriented transactional exchange initiatives, schemes, ocurrences, happenings, interactions, processes, methods, practices, movements, proceedings, messaging, presentations, notifications, filings, submissions, records, activities, actions, events, endeavors, tasks and affairs, concerning members of the aforementioned UNIVERSAL POPULACET™, which as herein referenced are evidently logical and necessary participants with aforementioned fragmenting capital market inefficiencies, and thereupon within the aforementioned efficient UNIVERSAL ECONOMY™. Whereas, it is an undeniable and evidentiary findings of fact, documented reference and evidently logical deductive reasoning that subsequent to the so-called AICPA special committee two-year initiative to report and deliberate on the changing role of the profession of public accounting and public auditing identified nine major megatrends which embody information technology, competition, corporate structure, accountability, transactional exchange capital, population aging, globalization, education and the legal environment, wherein it further concluded that the future cannot be predicted with sufficient certainty for outlines to serve any useful purpose for skilled practicioners in the fields of public accounting and public auditing but nevertheless attempted to describe its findings and deliberations. The so-called AICPA special committee was adamant in evincing that its determinations involving its reports and findings were the strict result of its extensive deliberations assisted by an outside consulting firm, wherein no additional findings from research on customer needs or on the future of the present services of public accounting and public auditing changed the determinations on external factors, but they were nonetheless supported by empirical every and all real-time processing and/or public accounting and public auditing in the new milennium by categorizing three distinctively separate areas which embodied providing necessary every and all real-time processing and/or reprocessing of data and/or information receiver to members of the aforementioned UNIVERSAL POPULACE™, providing so-called assurance service pertaining to newly defined accountabilities inclusive of the measurement of accountabilities, and providing intermediary services on behalf of principals members of the aforementioned UNIVERSAL POPULACE™. It is an undeniable and evidentiary finding of fact, documented reference and evidently logical scientific deduction reasoning that the so-called AICPA special committee reported that its deliberations concerning information technology evinced that its capabilities will continue to advance and technological advances in compression technologies will allow high quality images to be managed by ordinary computers, optical disk storage capacities will expand exponentially, network routing capabilities will ineviably enable more efficient flows of every and all real-time processing and/or reprocessing of data and/or information receiver while the futrue would concretize cheaper computing processing power, newly conceived, engineered, designed and developed via contructive reduction to practice computing architectures, dramatic decreases in the costs of memory, digital communications network and new graphical user-friendly interfaces while a new computing paradigm shift would lead to imminent changes in a shift toward a service oriented global marketplace, increases in hom offices, increases in mobile offices, conferencing and networking improvements, flexible schedules, a growth of contingent staff personnel workforces, and growth of self-employed professionals. The so-called AICPA special committees deliberation results further evinced that more every and all real-time processing and/or reprocessing of data and/or information receiver would be availabe and become customizable to meet the needs members of the aforementioned UNIVERSAL POPULACE™ permitting changes in organizational structures between and among suppliers and distributors riasing security issues and a changing nature of the traditional supplier and customer busines models wherein every and all real-time processing and/or reprocessing of data and/or information receiver would be accessible more quickly, decision speeds would decrease, and every and all real-time processing for filters to synthesize or select relevant every and all real-time processing and/or reprocessing of data and/or information receiver. Whereas, it is an undeniable and evidentiary findings of fact, documented reference and evidently logical scientific deduction reasoning that the so-called AICPA special committees deliberation results further evinced that control would become automated and more complex requiring new knowledge and new decision-making models premised on an increased reliance on information technologists, decreased reliance on certified public accountants and certified public auditors who would likely lack every and all of the knowledge, skills, image or competence demanded by the marketplace environment and evidently new information technology would emancipate and enfranchise members of the aforementioned UNIVERSAL POPULACE™ form this present traditional stronghold and present enthrallment of certified public accountants and certified public auditors over the role and profession of public accounting and public auditing. Moreover, the so-called AICPA special committee recognized that its so-called assurance services might evidently lose every and all inherent value of the complex architecture and sophisticated technological computing processing systems of the future would inherently be certified and preferentially accepted as incorporating every and all necessary accuracy, quality, integrity, honor, timeliness, relevance, transparency, reliabilty, verifiability, comprehensiveness, understandability and assurance of the aforementioned PUBLIC FINANCIALS™ statements inclusive of seamlessly and naturally wrapped, twisted, mixed, convoluted, embroidered and combined in connection with aforementioned PUBLIC FINANCIALS™ instruments thus further increasing the pressure of tempestuous diminishing role of historical strong-hold and power of enthrallment of certified public accountants and ceritified public auditors over members of the aforementioned UNIVERSAL POPULACE™ in serving as the market domineering providers of public accounting and public auditing related products and services. Furthermore, the so-called AICPA special committees two-year extensive report findings and deliberations evinced that it may be inevitable that the future of transactional oriented interchange and exchange initiatives, schemes, ocurrences, happenings, interactions, processes, methods, practices, movements, proceedings, messaging, presentations, technological advancements in utility engineering and architectural design propagations universal microprocessor computing design provisions leading to products, goods, supplies and services managed predominately in a digital oriented global marketplace emancipate and enfranchised from this limitation of the present and historical paper-based economies, thus increasing the exponential potential of damages, losses and/or injuries related to copy, reengineering, theft and fraud involving public accounting and leading toward new approaches in providing the world necessary public auditing functions, which as herein referenced should ultimately embody accuracy, quality, integrity, honor, timeliness, relevance, transparency, reliabilty, verifiability, comprehensiveness, understandability and assurance of the aforementioned PUBLIC FINANCIALS™ statements inclusive of seamlessly and naturally wrapped, twisted, mixed, convoluted, embroidered and combined in connection with aforementioned PUBLIC FINANCIALS™ instruments reported by members of the aforementioned UNIVERSAL POPULACE™ inclusive of, without limitation, every and all aforementioned PUBLIC FINANCIALS™ instruments transactional exchange data with aforementioned PUBLIC FINANCIALS™ instruments transactional exchange information with aforementioned fragmenting capital market inefficiencies. Whereas, it is an undeniable and evidentiary findings of fact, documented reference and evidently logical scientific deduction reasoning premised on the so-called AICPA special committee two-year extensive report and deliberations that the nature of the old audit paradigm as a set of quarterly and annual PUBLIC FINANCIALS™ statements accompanied by an annual public audit submitted to the so-called U.S. SEC and/or the applicable governing bodies and/or regulatory authorities may be in direct contrast in the new milennium of the twenty-first century which would evolve and adapt to the marketplace demands of the information age potentially leading to a set of continuous professional assurances offered to emancipate and enfranchise members of the aforementioned UNIVERSAL POPULACE™ with novel and unobvious UCMOST real-time processing and/or reprocessing transmission of PUBLIC FINANCIALS™ statements seamlessly and naturally integrated and interlocked with PUBLIC FINANCIALS™ instruments. Whereas, it is an undeniable and evidentiary findings of that it postulates that at some time in beginning of the new milennium an inevitable shift in power will begin to occur as the world enters the information age which may inevitably transport power from members of the aforementioned UNTVERSAL POPULACE™ regarding disclosure of PUBLIC FINANCIALS™ statements with PUBLIC FINANCIALS™ instruments, including, without limitation, when and how to disclose to members of the aforementioned UNIVERSAL POPULACE™ may eventually be concretizing in the global marketplace, wherein the special committee strongly believes there is an imminent paradigm shift occurring regarding every and all techniques, designs, systems, routines, devices, manners, modes, fashions, forms, formats, factors, objects, parts, segments, elements, components, constituents, ingredients, processes, methods and combinations of every and all real-time processing and/or reprocessing of data and/or information receiver interchange and exchange in this intrinsically integrated and exponentially seamless global marketplace, and thereby the professional role and present historical strong-hold and power of enthrallment and enthrallment of certified public accountants and certified public auditors over public data and public information comprehensively suitable, generally pertinent and broadly useful to their archaic and historical notions, approaches and methods involving the retrieval, processing, storage, gathering, compiling, tabulating, casting, calculating, preparing, presenting and submitting aforementioned PUBLIC FINANCIALS™ statements inclusive of seamlessly and naturally wrapped, twisted, mixed, convoluted, embroidered and combined in connection with aforementioned PUBLIC FINANCIALS™ instruments from public organization in a highly dynamic, fiercly competitive and inhrently volatile global marketplace. Accordingly, the so-called AICPA special committees two-year extensive report findings and deliberations recognized that now more than ever before in the history of the professional role of certified public accountants and certified public auditors the varying industries and sectors that transcend our so-called U.S. economy and most foreign sovereign national econoimces from around the world must sharpen their focus especially regarding adherence to and compliance to unknown and unforeseen principles, standards, and practices which shall evolve from our history into an newly developing information age service oriented and digital-based global marketplace aforementioned UNIVERSAL POPULACE™, certified public accountants and certified public auditors must upgrade their knowledge, skills, education, talents, abilities and thereupon increasingly become more responsive to the unmet needs members of the aforementioned UNIVERSAL POPULACE™ while improving the accuracy, quality, integrity, honor, timeliness, relevance, transparency, reliabilty, verifiability, comprehensiveness, understandability and assurance of the aforementioned PUBLIC FINANCIALS™ statements inclusive of seamlessly and naturally wrapped, twisted, mixed, convoluted, embroidered and combined in connection with aforementioned PUBLIC FINANCIALS™ instruments reported by members of the aforementioned UNIVERSAL POPULACE™ and thereby made available in digital oriented global marketplace of the future. It is also undeniable and evidentiary findings of fact, documented reference and evidently logical scientific deduction reasoning premised on the so-called AICPA special committee two-year extensive report and deliberations that dated public accounting and public auditing may at some time in the new milennim of the twenty-first century be supplanted by some unknown and unforeseen techniques, designs, systems, routines, devices, manners, modes, fashions, forms, formats, factors, objects, parts, segments, elements, components, constituents, ingredients, processes, methods and combinations of every and all real-time processing and/or reprocessing of data and/or information receiver content management involving more efficiency and effectiveness to the global marketplace than the archaic and historical industry and sector-wide standard time-lagged public accounting transport reconciling, independent public auditing and financial reporting which heretofore precludes, prevents, enthralls, engulfs and oppresses optimized and efficient transport flow of real-time processing of data and/or information receiver within the aforementioned fragmenting capital market inefficiencies. Whereas, it is an undeniable and evidentiary findings of fact, documented reference, logical scientific deduction and intuitive analytical reasoning that the and documented reference that the so-called AICPA anticipates the market environment for professional assurance within ten years henceforth from it special committees two-year extensive report and deliberation expand broadly pertaining to public accounting and independent public auditing services and exceed US$21 billion in annual gross revenues. Whereas, it is an revenues involving the automated and controlled global marketplace of public accounting, independent auditing and financial reporting in the new milennium is understated, empirically illogical and false and misleading in its aim, letter, nature, breadth, sound, depth, spirit and scope. More importantly, and in direct contrast to these so-called AMCPA's findings and documented references, it is clearly an undeniable and evidentiary findings of fact, documented reference, logical scientific deduction and intuitive analytical reasoning that every and all members of the aforementioned UNIVERSAL POPULACE™ are inevitably expected to establish independent digital connections with a a legally established free-market and independently owned, operated, managed and administrated proprietary holistically steady state indistinguishably synchronized real-time processing of data and/or information receiver depository product and service provider which innovatively conceives, engineers, designs and develops software programs and operating systems programs embodying utility engineering and architectural design propagations universal microprocessor computing design provisions which continuously and perpetually incorporate every and all necessary accuracy, quality, integrity, honor, timeliness, relevance, transparency, reliabilty, verifiability, comprehensiveness, understandability and assurance aforementioned PUBLIC FINANCIALS™ statements inclusive of seamlessly and naturally wrapped, twisted, mixed, convoluted, embroidered and combined in connection with aforementioned PUBLIC FINANCIALS™ instruments concerning commercial oriented transactional exchange initiatives, schemes, ocurrences, happenings, interactions, processes, methods, practices, movements, proceedings, messaging, presentations, notifications, filings, submissions, records, activities, actions, events, endeavors, tasks and affairs. Whereas, it is an undeniable and evidentiary findings of fact, documented reference, logical scientific deduction and intuitive analytical reasoning that the novel, unobvious, unique, unknown, unforeseen, unprecedented, ease of use and panacean cutting-edge technological innovation invoked within aforementioned UCMOST™ information technology is furthermore comprehensively suitable, generally pertinent and broadly useful utility and design formulation herewith existent innovative developments and technological advancements which concretize a legally established free-market and independently depository product and service provider of every and all aforementioned PUBLIC FINANCIALS™ statements inclusive of seamlessly and naturally wrapped, twisted, mixed, convoluted, embroidered and combined in connection with aforementioned PUBLIC FINANCIALS™ instruments from members of the aforementioned UNIVERSAL POPULACE™ in combination with every and all PUBLIC FINANCIALS™ instruments data in connection with PUBLIC FINANCIALS™ instruments information which are undeniably, respectively, independently, autonomously, evidently, undeniably, logically, scientifically and intuitively the exclusive drivers of every and all transactional exchange initiatives, schemes, ocurrences, happenings, interactions, processes, methods, practices, movements, proceedings, messaging, presentations, notifications, filings, submissions, records, activities, actions, events, endeavors, tasks and affairs, which hereto entail, encompass, comprise, involve, impact and effect UCMOST information technologies which are comprehensively suitable, generally pertinent and broadly useful to supplant every and all antiquated, archaic, ancient history and superannuated preconceived notions of the following: retrieving; converting; formatting; processing; storing; gathering; compiling; tabulating; casting; calculating; preparing; editing; tracing; verifying; submitting; confirming; validating; booking; classifying; categorizing; adjusting; altering; revising; changing; billing; collecting; producing; composing; conducting; proofing; filtering; pressing; publishing; cataloging; indexing; scripting; locating; shooting; running; releasing; posting; compressing; presenting; releasing; playing; displaying; projecting; broadcasting; syndicating; whereas, inclusive of, without limitation, supplanting every and all antiquated, archaic, ancient history and superannuated preconceived notions of the following: reretrieval; retransport; reconversion; reformatting; reprocessing; resaving; restoring; reidentifying; regathering; resorting; reorganizing; recompiling; retabulating; recasting; recalculating; repreparing; reediting; retracing; reverifying; resubmitting; reconfirming; revalidating; rebooking; reclassifying; recategorizing; readjusting; realtering; rerevising; rechanging; recharging; rebilling; recollecting; reproducing; recomposing; reconducting; reproofing; refiltering; repressing; republishing; recataloging; reindexing; rescripting; wherefrom eradicating every and all useless dated PUBLIC FINANCIALS™ statements hretofore traditionally separate and heretofore mutuallly exclusive dated PUBLIC FINANCIALS™ instruments thereby concretizing real-time optimized and efficient transport flow of every and all real-time processing and/or reprocessing of data and/or information receiver anytime, anyplace and anywhere within, throughout and transcending a single holistic econometric marketplace environment concerning and pertinaing to any an all basic elemental developments, necessary interactions and integral transactional exchange initiatives, schemes, ocurrences, happenings, interactions, processes, methods, practices, movements, proceedings, messaging, presentations, notifications, slings, submissions, records, activities, actions, events, endeavors, tasks and affairs which are hereto discovered to be wide-spread and intrinsically prevelant within an aforementioned efficient UNIVERSAL CAPITAL MARKET™. Wherefrom furthermore the above aforementioned clearly, undeniably, logically, scientifically and intutively embroider, embody and supplant every and all heretofore preconceived malicious and menacing beliefs concerning the distinctively separate and traditionally exclusive speciality areas involving public accounting, transport reconciling, independent auditing, financial reporting inclusive of, without limitation, order-entry quotation, matching, clearance, execution, settlement and exchange of insurance, risk financing, credit, cash management, investment banking and aforementioned PUBLIC FINANCIALS™ instruments transactional exchanges to concretizing transmuting traverse formation and infinite establishment of heliocentrically efficient, effective, functional and integrated streamlined, alternating scale, inseparable, seamless and natural wrapping, interlacing, coiling, coupling, combining and interlocking techniques, designs, systems, routines, devices, manners, modes, fashions, forms, formats, factors, objects, parts, segments, elements, components, constituents, ingredients, processes, methods and combinations entailing, encompassing, comprising, involving, impacting and/or effecting automatizing real-time holistically steady state synchronized ubiquitous continuum real-time rhombus microprocessing instantaneous transmission and receiver transforming traverse conduit real-time processing of data and/or information receiver related to every and all factors comprising data and/or informaiton content management, financial initiatives, schemes, ocurrences, happenings, interactions, processes, methods, practices, movements, proceedings, messaging, presentations, notifications, filings, submissions, records, activities, actions, events, endeavors, tasks and affairs. Whereas, it is an undeniable and evidentiary findings of fact, documented reference, logical scientific deduction and intuitive analytical reasoning that the novel, unobvious, unique, unknown, unforeseen, unprecedented, ease of use and panacean cutting-edge technological innovation invoked within aforementioned UCMOST™ information technology is furthermore comprehensively suitable, generally pertinent and broadly useful utility and design formulation herewith existent innovative developments and technological advancements which concretize a legally established free-market and independently owned, operated, managed and administrated proprietary holistically steady state indistinguishably synchronized real-time processing of data and/or information receiver depository product and service provider may herewith inevitably offer members of the aforementioned UNIVERSAL POPULACE™ an unknown, unforeseen and unprecedented commercial formation establising a new theater and higher standards for an aforementioned efficient UNIVERSAL CAPITAL MARKET™ whose incudement is a necessary inteegrated and increasing integral aforementioned efficient UNIVERSAL ECONOMY™ wherein each respectively, autonomously, anonymously, independently, anonymously and impartially receives access the commercial offering of utility engineering and architectural design of software products and services to assist them perpetually in protecting, sustaining and expanding their treasure accounting, financial fueling and econometric energizing in a highly dynamic and inherently volatile, fragile, frigid and ruthless global marketplace. Whereas, it is an undeniable and evidentiary findings of fact, documented reference, logical scientific deduction and intuitive analytical reasoning that the novel, unobvious, unique, unknown, unforeseen, unprecedented, ease of use and panacean cutting-edge technological innovation invoked within aforementioned UCMOST information technology is furthermore comprehensively suitable, generally pertinent and broadly usefiul utility and design formulation herewith existent innovative developments and technological advancements which concretize a legally established free-market autonomous, anonymous, time processing of data and/or information receiver depository software products and services provider of innovations developments and advancement which offer seamless and natural wrapping twisting, coupling and combining every and all of the distinctively separate and traditionally exclusive specialty areas of public accounting, transport reconciling, independent auditing and financial reporting inclusive of order-entry quotation, matching, clearance, settlement and excection of insurance, risk financing, credit, cash management, transactional exchange bankinga and aforementioned PUBLIC FINANCIALS™ instruments to be admant and rigorous in pursuit of eradicating every and all continued and perpetual harming, damaging, inuring, insistent, insinuating, imposing, pestilent, impetuous, importune, pestiferous, condescending and insolent enthralling, hindering, entrapping, pretending, miring, fatiguing, maleficience, harassing, engulfing, pressing, malevolent, presuming, imprinting, malicious, suffocating, miring, stranging, repressing, entangling, pestering and oppressing individual members of the aforementioned UNIVERSAL POPULACE™ which are traditionally concretizing via inefficient, ineffective, dysfunctional and fragmented vast networks of antiquated, archaic, ancient history and superannuated aforementioned PUBLIC FINANCIALS™ organizations which heretofore continuously, arrogantly, imprudently, irrationally and irresponsibly engage in propagating aforementioned fragmenting capital market inefficiencies via the communicating conduits of conceptual aids within a single holistically econometric marketplace environment. It is also an undeniable and evidentiary findings of fact, documented reference, logical scientific deduction and intuitive analytical reasoning that there present exists a tremendous long-held and enormous heart-felt need in the relevant art for adaptive evolution premised on innovatively groundbreaking and breakthrough utility engineering and architectural design propagations universal microprocessor computing design provisions comprising the preferred embodiments of aforementioned UCMOST™ information technology to concretize the formation of a new theater of commercial operations and establishment of higher standards of full disclosure, best practices, best executions, enhanced fairness, simultaneous equality, full transparency, consolidated access and perpetual integration of members members of the aforementioned UNIVERSAL POPULACE™ for an unkown hundreds of millions members of the aforementioned UNIVERSAL POPULACE™ can respectively at their leisurely convenience and premised strictly on their long-term plans, goals, objectives and tolerance for volatility seamlessly effectuate efficient, effective, objective, well-informed, risk-managed and self-assured aforementioned PUBLIC FINANCIALS™ instruments transactional exchange decision initiatives schemes ocurrences, happenings, interactions, processes, methods, practices, movements, proceedings, messaging, presentations, notifications, filings, submissions, records, activities, actions, events, endeavors, tasks and affairs to protect, sustain and expand their treasure accounting, financial fueling and econometric energizing in a highly dynamic and inherently volatile and ruthless global marketplace to therewithal put forth a good samaritan best efforts to mitigate every and all tempestuous exponentially detrimental increases in systematic volatility and tempestuous exponentially debilitating increases in the cost of capital requited in a single holistically econometric marketplace environment of the new milennium. It is also an undeniable and evidentiary findings of fact, documented reference, logical scientific deduction and intuitive analytical reasoning Whereas, it is an undeniable and evidentiary findings of fact, documented reference, logical scientific deduction and intuitive analytical reasoning that the novel, unobvious, unique, unknown, unforeseen, unprecedented, ease of use and panacean cutting-edge technological innovation invoked within aforementioned UCMOST™ information technology is furthermore comprehensively suitable, generally pertinent and broadly useful utility and design formulation herewith existent innovative developments and technological advancements concretize a legally established free-market and independently owned, operated, managed and administrated proprietary holistically steady state indistinguishably synchronized real-time processing of data and/or information receiver depository product and service provider will inevitably premise its commercial oriented operations, finances and transactional exchange in incorporating an aforementioned efficient UNIVERSAL CAPITAL MARKET™ second-to-none in the world offering high-quality, high-integrity and the highest levels of perpectual assuarances pertaining to utilization of full disclosure, best practices, best executions, enhanced fairness, simultaneous equality, full transparency, consolidated access and acitivities within an aforementioned efficient UNIVERSAL CAPITAL MARKET™ by creating formulae which embodies conception, engineering, design and development via to constructve reduction to practice aforementioned UCMOST™ real-time processing and/or reprocessing of data and/or information involving every and all aforementioned PUBLIC FINANCIALS™ statements naturally and seamlessly intertwined, embroidered and embodying and involving every and all aforementioned PUBLIC FINANCIALS™ instruments seamlessly and naturally wrapped, twisted, mixed, convoluted, embroidered and combined in connection with aforementioned PUBLIC FINANCIALS™ instruments transactional exchange data and aforementioned PUBLIC FINANCIALS™ instruments transactional exchange information which transcend most sovereign national economic trading blocs in existence on planet earth. Therewithal, it is an undeniable and evidentiary finding of fact, documented reference, logical scientific deduction and intuitive analytical reasoning that time-lagged, hesistant, holding, restricting, restraining and dated audits aforementioned PUBLIC FINANCIALS™ statements inclusive of seamlessly and naturally wrapped, twisted, mixed, convoluted, embroidered and combined aforementioned PUBLIC FINANCIALS™ instruments should hereto necessarily, inherently and intrinsically be a requisite of the underlying principles, standards, interpretations and guidelines of a single holistically econometric marketplace environment premised on the transmuting identic rubric transnational diplomatics propagating generally accepted public accounting as a logical derivative propagating independently and perpetually automatizing and projecting public auditing systems, methods, procedures and combinations which innately and intrinsically adhere to and comply with every and all laws, statues, governing rules and authoritative regulations involving the so-called U.S. Securities and Exchange Commission (SEC); International Organization of Securities Commissioners (IOSCO); General Accepted Accounting Principles (GAAP); General Accepted Auditing Standards (GAAS); Financial Accounting Standards Board (FASB); Government Accounting Standards Board (GASB); International Accounting Standards (IAS) and International Accounting Standards Board (IASB); inclusive of, without limitation, offering full disclosure, best practices, best executions, enhanced fairness, simultaneous equality, full transparency, data and/or information to effectuate every and all aspects, topics, elements, components, issues and matters of the basic elemental developments, necessary interactions and integral transactional exchange driven initiatives, schemes, ocurrences, happenings, interactions, processes, methods, practices, movements, proceedings, messaging, presentations, notifications, filings, submissions, records, activities, actions, events, endeavors, tasks and affairs which they encounter in the walks of life and livelihoods. But nonetheless, it is clearly an undeniable and evidentiary findings of fact, documented reference, logical scientific deduction and intuitive analytical reasoning that the information age of the new milennium which shall inevitably evolve and adapt exclusively to a paper-less global marketplace digital environment, focus imminently shifts toward acquiring real-time audit related every and all real-time processing and/or reprocessing of data and/or information receiver seamless across industries and sectors of every and all sovereign national economies premised on incorporating full disclosures, best practices and best executions to offer the highest probable and reasonable levels of assurance while perpetually incorporating every and all necessary accuracy, quality, integrity, honor, timeliness, relevance, transparency, reliabilty, verifiability, comprehensiveness, understandability and assurance pertaining to aforementioned PUBLIC FINANCIALS™ statements and real-time public non-financial informaiton seamlessly and naturally wrapped, twisted, mixed, convoluted, embroidered and combined in connection with aforementioned PUBLIC FINANCIALS™ instruments transactional exchange data and aforementioned PUBLIC FINANCIALS™ instruments transactional exchange information which transcends every and all national boundaries in an invisible fashion wherein logical scientific deduction reasoning evinces that illogical and obscure concepts entailing, encompassing and comprising every and all time-lagged disclosures involving aforementioned PUBLIC FINANCIALS™ statements inclusive of seamlessly and naturally wrapped, twisted, mixed, convoluted, embroidered and combined in connection with aforementioned PUBLIC FINANCIALS™ instruments inclusive of without limitation, the archaic and historical notions of annual audits and segmented materiality inevitably will logically become mute points, aspects, topics, elements, components, issues and matters of the integrated world of public accounting, findings of fact, documented reference, logical scientific deduction and intuitive analytical reasoning that present big five limited liability partnerships which have historically provided public accounting and independent public auditing of the aforementioned PUBLIC FINANCIALS™ statements to top-tier major, extemely prominent and well-established multinational members of the aforementioned UNIVERSAL POPULACE™ in the world, inclusive of, without limitation their subsidiary branches which encompass operations, finance and transactional exchanges in both domestic and foreign territories. It is also an undeniable and evidentiary findings of fact, documented reference, logical scientific deduction and intuitive analytical reasoning that the dramatic uprising and growing demand of information technology has over the last couple of decades shifted the focus of these big five limited liability partnerships toward providing technical consulting services and information technology intermediary services to the top-tier major, extremely prominent and well-established multinational individual members of the aforementioned UNIVERSAL POPULACE™ of a single holistically econometric marketplace environment, therein deriving the largest majority of their revenues, expenditures, performance and progtability inclusive of, without limitation, every and all rewards therefrom has inevitably changed the business models of these so-called public accounting and so-called independent public auditing so-called partnerships. Whereas, it is an undeniable and evidentiary findings of fact, documented reference, logical scientific deduction and intuitive analytical reasoning that this shift of the big five limited liability partnership has evidently come at the expense of loss of independence and derivative cost of service to members of the hereto members of the aforementioned UNIVERSAL POPULACE™ in their providing public accounting and public auditing services to the top-tier major, extremely prominent and well-established multinational aforementioned PUBLIC FINANCIALS™ organizations of a single holistically econometric marketplace environment, and to the detriment of the high-quality and high-integrity driven public accounting and public auditing needs members of the aforementioned UNIVERSAL POPULACE™ who necessitate the highest levels of assurance pertaining to every and all basic elemental developments, necessary interactions and integral transactional exchange initiatives, schemes, ocurrences, events, endeavors, tasks and affairs involving the necessary accuracy, quality, integrity, honor, timeliness, relevance, transparency, reliabilty, verifiability, comprehensiveness, understandability and assurance aforementioned PUBLIC FTNANCIALS™ statements inclusive of seamlessly and naturally wrapped, twisted, mixed, convoluted, embroidered and combined in connection with aforementioned PUBLIC FINANCIALS™ instruments within an aforementioned efficient UNIVERSAL CAPITAL MARKET™ Whereas, it is an undeniable and evidentialy findings of fact, documented reference, logical scientific deduction and intuitive analytical reasoning that at a minium one of these big five limited liability partnerships already transformed its legal existence and/or status to become one of the tens of thousands aforementioned PUBLIC FINANCIALS™ organizations whose aforementioned PUBLIC FINANCIALS™ instruments are registered, listed and publicly exchange within a capital market, while at a minimum one other big five limited liability partnership has been recently actively engaged in attempting to legally segment the public accounting and public auditing divisions as a consequence of the so-called U.S. SEC and other applicable governing bodies and regulatory authorities questioning the independence and clear and apparent conflict of interests pertaining to their illogically attemtping to justify their providing technical consulting services and information technology intermediary services to the top-tier major, extremely prominent and well-established multinational members of the aforementioned UNIVERSAL POPULACE™ while conpresent albeit in a futile attempt continuing to provide public accounting and and so-calleed independnet public auditing services to these same top-tier major, extremely prominent and well-established multinational members of the aforementioned UNIVERSAL POPULACE™. Furthermore, at a minimum one of these big five limited liability partnerships has actively engaged in pursuing the acquisition and/or merger of its public accounting services with a major hardware computer manufacturer in an attempt to further instill their historical strong-hold and power of enthrallment over the distictively separate and traditionally exclusive areas of public accounting, independent auditing and financial reporting, of which every and all of these aforementioned legal manuevers and capital financing initiatives have been promulgated in an attempt to diminish the so-called U.S. SEC's and other applicable governing bodies and regulatory authority evince loss of independence from the senior executive stronghold over the principles, standards, interpretations and guidelines which govern public accounting and public auditing within an aforementioned efficient UNIVERSAL CAPITAL MARKET™, at the expense and detriment of the high-quality, high-integrity and highest levels of assurance necessary for individual members of the aforementioned UNIVERSAL POPULACE™ to maintain and increase their trust and confidence within the aforementioned PUBLIC FINANCIALS™ statements inclusive of seamlessly and naturally wrapped, twisted, mixed, convoluted, embroidered and combined in connection with aforementioned PUBLIC FINANCIALS™ instruments from every and all members of the aforementioned UNIVERSAL POPULACE™ which logical and necessarily participate with aforementioned fragmenting capital market inefficiencies. Whereas, it is an undeniable and evidentiary findings of fact, documented reference and logical deductives scientific reasoning that the legal entity status, organizational cultures, and long-held traditions of these big five limited liability partnerships will be hard-pressed to adapt and/or evolve to every and all requisite change pertaining to their providing technology consulting and information technology intermediary services to top-tier major, extremely prominent and well-established multinational members of the aforementioned UNIVERSAL POPULACE™ because these firms have evinced and profited lucratively from the clear, logical and evidentiary change in core revenue streams which have sustained their enterprise operations for more than two decades. Therefore, it is clearly an undeniable and evidentiary findings of fact, documented reference, logical scientific deduction and intuitive analytical reasoning that any techniques, designs, systems, routines, devices, manners, modes, fashions, forms, formats, factors, objects, parts, segments, elements, components, constituents, ingredients, processes, methods and combinations involving futile attempts at legal separation among the public accounting and public auditing divisions of these big five limited liability partnerships in no techniques, designs, systems, routines, devices, manners, modes, fashions, forms, formats, factors, objects, parts, segments, elements, components, constituents, ingredients, processes, methods and combinations offers an legally adequate, suitable or sustainable solution to mitigate their contributory role in the tempestuous diminished seamlessly and naturally wrapped, twisted, mixed, convoluted, embroidered and combined in connection with aforementioned PUBLIC FINANCIALS™ instruments with aforementioned fragmenting capital market inefficiencies which are the essence and requiste premise necessary for individual members of the aforementioned UNIVERSAL POPULACE™ to sustain and improve their trust and confidence inmembers of the aforementioned UNIVERSAL POPULACE™ and the valuations of their aforementioned PUBLIC FINANCIALS™ instruments registered, listed and exchanged with aforementioned fragmenting capital market inefficiencies. Heretofore, there is an overwhelming, certainly undeniable and evidentiary findings of fact, documented reference, logical scientific deduction and intuitive analytical reasoning which conclusively evinces that information technology empower man like no other recent innovative developments and technological advancements in history, but their perpetual and positve enabling impact on the world thus far albeit enormous are still extremely limited, but hereupon and henceforth our experience of their novel and innovative utility engineering and architectural design propagations universal microprocessor computing design provisional benefits for individual members of the aforementioned UNIVERSAL POPULACE™ are simply the beginning of a series of more profound and far-reaching adaptive evolutionary changes yet to be concretizing. It is an undeniable and evidentiary fidnings of fact, documented reference, logical scientific deduction and intuitive analytical reasoning that the senior executives members of the aforementioned UNIVERSAL POPULACE™ are at a crossroad in a world of enormous legal, regulatory, economic, financial, accounting and auditing risk concerning every and all partial bias against implmenting strategic adaptive evolutionary changes in communicating every and all techniques, designs, systems, routines, devices, manners, modes, fashions, forms, formats, factors, objects, parts, segments, elements, components, constituents, ingredients, processes, methods and combinations of real-time processing of data and/or information receiver to the so-called U.S. SEC, applicable governing bodies and regulatory authorities inclusive of, without limitation, tens of thousands members of the aforementioned UNIVERSAL POPULACE™ and hundreds of millions members of the aforementioned UNIVERSAL POPULACE™ throughout the world at large who schemes, ocurrences, happenings, interactions, processes, methods, practices, movements, proceedings, messaging, presentations, notifications, filings, submissions, records, activities, actions, events, endeavors, tasks and affairs involving the necessary accuracy, quality, integrity, honor, timeliness, relevance, transparency, reliabilty, verifiability, comprehensiveness, understandability and assurance aforementioned PUBLIC FINANCIALS™ statements and real-time PUBLIC FINANCIALS™ instruments inclusive of every and all necessarily integrated, critically important and increasingly integral aforementioned PUBLIC FINANCIALS™ instruments transactional exchange data and aforementioned PUBLIC FINANCIALS™ instruments transactional exchange information within an aforementioned efficient UNIVERSAL CAPITAL MARKET™, which hereto and hereafter aforementioned UCMOST™ information technology embodies., encompasses and comprises via streamlined, alternating scale, inseparable, seamless and natural wrapping, interlacing, coiling, coupling, combining and interlocking proprietary software graphical user interfaces, proprietary software application programs, proprietary software microprocessor computing systems, proprietary software streamlined procedural processes, proprietary novel business methods and proprietary multiport revolving chambered homing binary hunting metallic track encasing hermetic data link caster dart castings constrained new combinations of retrieving, processing, storing, gathering, compiling, tabulating, casting, calculating, preparing, presenting, booking, classifying, categorizing, adjusting, altering, revising, changing, charging, billing, collecting, producing, composing, conducting, proofing, filtering, pressing, publishing, cataloging, indexing, posting, compressing, releasing, playing, displaying, broadcasting, distributing and/or syndicating transmission, rebroadcasting, redistributing and/or resyndicating transmission, distributing and syndicating aforementioned PUBLIC FINANCIALS™ statements and real-time PUBLIC FINANCIALS™ instruments streamlined, alternating scale, inseparable, seamless and natural wrapping, interlacing, coiling, coupling, combining and interlocking with aforementioned PUBLIC FINANCIALS™ instruments transactional exchange data and aforementioned PUBLIC FINANCIALS™ instruments transactional exchange information, and every and all techniques, designs, systems, routines, devices, manners, of public organiziations, their industry sponsored members of the aforementioned UNIVERSAL POPULACE™, legal, regulatory, economic, financial, accounting and auditing interest groups which embark emphatically on contrarian agendas hereto and hereafter which attempt to preclude every and all techniques, designs, systems, routines, devices, manners, modes, fashions, forms, formats, factors, objects, parts, segments, elements, components, constituents, ingredients, processes, methods and combinations pertaining to offering enhanced fairness, simulteanoues equality, full transparency, consolidated access and perpetual integration to SEC, applicable governing bodies and regulatory authorities inclusive of, without limitation, tens of thousands members of the aforementioned UNIVERSAL POPULACE™ and hundreds of millions members of the aforementioned UNIVERSAL POPULACE™ throughout the world at large are logically preventing and/or working against the heretofore majority of public opinion and the essence of an aforementioned efficient UNIVERSAL CAPITAL MARKET™ which requires the highest of all potential levels of accuracy, quality, integrity, honor, timeliness, relevance, transparency, reliabilty, verifiability, comprehensiveness, understandability and assurance premised on optimized and efficient transport flow of every and all real-time processing and/or reprocessing of data and/or information receiver which innnately serves as the kernel of mitigating every and all tempestuous exponentially detrimental and tempestuous exponentially debilitating causes within an aforementioned efficient UNIVERSAL CAPITAL MARKET™ which preclude every and all protection, sustenance and expansion of the trust and confidence members of the aforementioned UNIVERSAL POPULACE™ in the UNIVERSAL CAPITAL MARKET™ of the twenty-first century, hereto and hereafter emtailing, encompassing and comprising the formation and establishment of a global commercialization of a uniquely novel, unobvious, unknown, unforeseen and unprecedented UNIVERSAL CAPITAL MARKET™ in a necessarily integrated, critically important and increasingly integral aforementioned efficient UNIVERSAL ECONOMY™. Whereas, it is an undeniable and evidentiaxy findings of fact, documented reference, logical scientific deduction and intuitive analytical reasoning that the so-called U.S. SEC and applicable governing bodies and regulatory authorities inclusive members of the aforementioned withmembers of the aforementioned UNIVERSAL POPULACE™ to meet their unmet needs pertaining to holistically steady state continuous spectrum ubiquitous indistinguishably synchronous needs involving aforementioned UCMOST™ real-time processing and/or reprocessing of data and/or information content management, financial services and aforementioned PUBLIC FINANCIALS™ instruments transactional exchange initiatives, schemes, ocurrences, happenings, interactions, processes, methods, practices, movements, proceedings, messaging, presentations, notifications, filings, submissions, records, activities, actions, events, endeavors, tasks and affairs. Whereas, it is an undeniable and evidentiary findings of fact, documented reference, logical scientific deduction and intuitive analytical reasoning that with aforementioned fragmenting capital market inefficiencies, the resonating stablization effect of aforementioned UCMOST™ information technology premised on full disclosure, best practices, best executions, enhanced fairness, simultaneous equality, full transparency, consolidated access and perpetual integration of members members of the aforementioned UNIVERSAL POPULACE™ in the highly dynamic and inherently volatile UNIVERSAL CAPITAL MARKET™ which drives the so-called U.S. economy and W.W. economies affords members of the aforementioned UNIVERSAL POPULACE™ the adaptive evolutionary and innovatively groundbreaking and breakthrough utility engineering and architectural design propagations universal microprocessor computing design provisonal benefits embodying aforementioned UCMOST™ information technology, which pertain and enable each respectively to seamlessly and naturally effectuating efficient, effective, streamlined, objective, well-informed, risk-managed and self-assured aforementioned PUBLIC FINANCIALS™ instruments transactional exchange decision initiatives, schemes, ocurrences, happenings, interactions, processes, methods, practices, movements, proceedings, messaging, presentations, notifications, filings, submissions, records, activities, actions, events, endeavors, tasks and affairs to protect, sustain and expand their treasure accounting, financial fueling and econometric energizing via their direct selection of membership subsciption services offered via a a legally established free-market and independently owned, operated, managed and administrated proprietary holistically steady state indistinguishably synchronized real-time processing of data deduction and intuitive analytical reasoning that a legally established free-market and independently owned, operated, managed and administrated proprietary holistically steady state indistinguishably synchronized real-time processing of data and/or information receiver depository product and service provider completely independent from every and all of the tens of thousands members of the aforementioned UNIVERSAL POPULACE™ and hundreds of millions members of the aforementioned UNIVERSAL POPULACE™ which are inevitably logical direct and indirect participants with aforementioned fragmenting capital market inefficiencies, and which is further is a legally established free-market and independently owned, operated, managed and administrated proprietary holistically steady state indistinguishably synchronized real-time processing of data and/or information receiver depository product and service provider encompassing and embodying every and all commercial oriented transactional exchange initiatives, schemes, ocurrences, happenings, interactions, processes, methods, practices, movements, proceedings, messaging, presentations, notifications, filings, submissions, records, activities, actions, events, endeavors, tasks and affairs, which hereupon and hereafter continues innovatively developing proprietary graphical user interfaces, proprietary software programs, proprietary operating systems programs, and every and all other relevant technologies, and which therein continuously develops and perpetually incorporates every and all necessary accuracy, quality, integrity, honor, timeliness, relevance, transparency, reliabilty, verifiability, comprehensiveness, understandability and assurance pertaining to every and all varying techniques, designs, systems, routines, devices, manners, modes, fashions, forms, formats, factors, objects, parts, segments, elements, components, constituents, ingredients, processes, methods and combinations of information technology which further involve every and all aspects, topics, elements, components, issues and matters concerning aforementioned PUBLIC FINANCIALS™ statements and real-time PUBLIC FINANCIALS™ instruments seamlessly and naturally wrapped, twisted, mixed, convoluted, embroidered and combined in connection with aforementioned PUBLIC FINANCIALS™ instruments transactional exchange data and aforementioned PUBLIC FINANCIALS™ instruments transactional exchange information which encompass every and all commercial oriented notifications, filings, submissions, records, activities, actions, events, endeavors, tasks and affairs aforementioned fragmenting capital market inefficiencies, thereupon logically, inevitably, and unrefutably serves in a positive enabling capacity to ensure that the best interests members of the aforementioned UNIVERSAL POPULACE™ are met in regards to any and techniques, designs, systems, routines, devices, manners, modes, fashions, forms, formats, factors, objects, parts, segments, elements, components, constituents, ingredients, processes, methods and combinations involving every and all real-time processing and/or reprocessing of data and/or information receiver content management, financial services and public aforementioned PUBLIC FINANCIALS™ instruments finanical transactional exchange instrument transactional exchange initiatives, schemes, ocurrences, happenings, interactions, processes, methods, practices, movements, proceedings, messaging, presentations, notifications, filings, submissions, records, activities, actions, events, endeavors, tasks and affairs premised on adamant utilization of every and all techniques, designs, systems, routines, devices, manners, modes, fashions, forms, formats, factors, objects, parts, segments, elements, components, constituents, ingredients, processes, methods and combinations of full disclosure, best practices, best executions, enhanced fairness, simultaneous equality, full transparency, consolidated access and perpetual integration of members members of the aforementioned UNIVERSAL POPULACE™ in every and all basic elemental developments, necessary interactions and integral transactional exchange initiatives, schemes, ocurrences, happenings, interactions, processes, methods, practices, movements, proceedings, messaging, presentations, notifications, filings, submissions, records, activities, actions, events, endeavors, tasks and affairs within an aforementioned efficient UNIVERSAL CAPITAL MARKET™ to concretize formation and establishment of a uniquely novel, unobvious, unknown, unforeseen and unprecedented UNIVERSAL CAPITAL MARKET™ in a necessarily integrated, critically important and increasingly integral aforementioned efficient UNIVERSAL ECONOMY™ which therein offers every and all intrinsically beneficial techniques, designs, systems, routines, devices, manners, modes, fashions, forms, formats, factors, objects, parts, segments, elements, components, constituents, ingredients, processes, methods and combinations of routines, devices, manners, modes, fashions, forms, formats, factors, objects, parts, segments, elements, components, constituents, ingredients, processes, methods and combinations of integrally bundled-in panacean cutting-edge graphical user interfaces, proprietary software programs, proprietary software program icons, proprietary operating systems programs, and proprietary operating systems program icons, tailored around innovative techniques, designs, systems, devices, processes, parts, segments, methods, combinations, know-how, ideas, art forms, articles of manufacture, discoveries, formulae, and architectural engineering of streamlined procedural computing process design compositions to interface aforementioned UCMOST™ information technology, which itself is panacean cutting-edge aforementioned UCMOST™ information technology invention pertaining to, without limitation, streamlined, alternating scale, inseparable, seamless and natural wrapping, interlacing, coiling, coupling, combining and interlocking proprietary graphical user interfaces, proprietary software application programs, proprietary software microprocessor computing systems, proprietary software streamlined procedural processes, proprietary novel business methods and proprietary multiport revolving chambered homing binary hunting metallic track encasing hermetic data link caster dart castings constrained new business combinations in programmed instruction entailing, encompassing, comprising, involving, impacting and/or effecting every and all one-time programmable read-only memory (PROM) of every and all central processing unit (CPU) as a highly efficient and highly effective technological development and advancement which offers tens of thousands members of the aforementioned UNIVERSAL POPULACE™ and hundreds of millions members of the aforementioned UNIVERSAL POPULACE™ from around the world low-cost economic benefits and high-quality personal efficiencies in every and all basic functional elements, necessary interactions and integral transactional exchange initiatives, schemes, ocurrences, happenings, interactions, processes, methods, practices, movements, proceedings, messaging, presentations, notifications, filings, submissions, records, activities, actions, events, endeavors, tasks and affairs found prevalent within an aforementioned efficient UNIVERSAL CAPITAL MARKET™ by creating innovative groundbreaking and breakthrough utility engineering and architectural design established free-market and independently owned, operated, managed and administrated proprietary PUBLIC FINANCIALS organization premised on an infinite melioristic logical positivism strive to innovative efficient, effective, functional and integrated resolution to every and all necessary streamlined, alternating scale, inseparable, seamless and natural wrapping, interlacing, coiling, coupling, combining and interlocking techniques, designs, systems, routines, devices, manners, modes, fashions, forms, formats, factors, objects, parts, segments, elements, components, constituents, ingredients, processes, methods and combinations involving every and all public accounting, transport reconciling independent auditing and financial reporting, inclusive of, without limitation, necessary streamlined, alternating scale, inseparable, seamless and natural wrapping, interlacing, coiling, coupling, combining and interlocking techniques, -designs, systems, routines, devices, manners, modes, fashions, forms, formats, factors, objects, parts, segments, elements, components, constituents, ingredients, processes, methods and combinations involving every and all order-entry quotation, matching, clearance, execution, settlement and exchange of insurance, risk financing, credit, cash management, investment banking and aforementioned PUBLIC FINANCIALS™ instruments transactional initiatives, schemes, ocurrences, happenings, interactions, processes, methods, practices, movements, proceedings, messaging, presentations, notifications, filings, submissions, records, activities, actions, events, endeavors, tasks and affairs to thereupon perpetually serve the best interests and long-term treasure accounting, financial fueling and econometric energizing of individual members of the aforementioned UNIVERSAL POPULACE™ via every and all aforementioned UCMOST™ real-time processing and/or reprocessing hereto concretizing via connsumate rubric praxis and constructive reduction to practice.

11. UCMOST™ Information Technology Application Software Program Factors

It is undeniable and evidentiary findings of fact, documented reference, logical scientific reasoning and intuitive analytical reasoning aforementioned UCMOST™ information technology offers tens of thousands members of the aforementioned UNIVERSAL panacean cutting-edge technological groundbreaking and breakthrough innovative utility engineering and aesthethic architectural universal microprocessor computing operating systems design emtailing, encompassing and comprising streamlined, alternating scale, inseparable, seamless and natural wrapping, interlacing, coiling, coupling, combining and interlocking proprietary software graphical user interfaces, proprietary software application programs, proprietary software microprocessor computing systems, proprietary software streamlined procedural processes, proprietary novel business methods and proprietary multiport revolving chambered homing binary hunting metallic track encasing hermetic data link caster dart castings constrained new combinations which intrinsically incorporates and is engineered for programmed instruction entailing, encompassing, comprising, involving, impacting and/or effecting every and all one-time programmable read-only memory (PROM) of every and all computing central processing units (CPU) which is representative and inclusive of, without limitation, every and all techniques, designs, systems, routines, devices, manners, modes, fashions, forms, formats, factors, objects, parts, segments, elements, components, constituents, ingredients, processes, methods and combinations of novel, unobvious, unique, unknown, unforeseen and unprecedented information technology devised from conception, engineering, design and development through to complete, consummate and constructive reduction to practice, Thereupon, it is undeniable and evidentiary findings of fact, documented reference, logical scientific reasoning and intuitive analytical reasoning aforementioned UCMOST™ information technology is further conceived, engineereed, designed and development through to complete, consummate and constructive reduction to practice with various proprietary software application programs in mindset which faciliate optimal and efficient interactive functionality to ensure that every and all techniques, designs, systems, routines, devices, manners, modes, fashions, forms, formats, factors, objects, parts, segments, elements, components, constituents, ingredients, processes, methods and combinations of enhanced fairness, simulteanoues equality, full transparency, consolidated access and perpetual integration to full disclosure, best practices, best executions, enhanced fairness, simultaneous equality, full transparency, consolidated access and perpetual integration of members members of the members of the aforementioned UNIVERSAL POPULACE™ wherein various proprietary techniques, designs, systems, routines, devices, manners, modes, fashions, forms, formats, factors, objects, parts, segments, elements, components, constituents, ingredients, processes, methods and combinations of trademarks and/or service are useful in commercializing formation and establishment of a novel, unobvious, unique, unknown, unforeseen and unprecedented the novel, unobvious, unique, unknown, unforeseen, unprecedented, ease of use and panacean cutting-edge technological innovations invoked within aforementioned UCMOST™ information technology is moreover comprehensively suitable, generally pertinent and broadly useful utility and design formulation herewith existent innovative developments and technological advancements of the aformentioned efficient UNIVERSAL CAPITAL MARKET™ in a necessarily integrated, critically important and increasingly integral aforementioned effcient UNIVERSAL ECONOMY™ which are inclusive of without limitation, PUBLIC FINANCIALS™; PUBLIC FINANCIALS CORPORATION™; UNIVERSAL CAPITAL MARKET™; UNIVERSAL ECONOMY™; UCMOST™ COMMERCE SLOGAN-ESTABLISHING A NEW THEATER AND HIGHER STANDARDS FOR A UNIVERSAL CAPITAL MARKET™; and PUBLIC FINANCIALS™ COMMERCE SYMBOL: A NOVEL AND UNIQUE HOLISTIC CIRCULAR FIGURATIVE REPRESENTATIONAL PLANET EARTH ENCAPSULATED BY FOUR EQUALLY SPACED CIRCULAR DESIGNED ORBITAL RINGS OF FOUR DISTINCTIVE COLORS WHICH FURTHER EMBODY TWENTY-ONE EQUALLY SPACED HELIX BAY ORBITAL SATELLITE STATION POINT FLAMES IDENTIFLIBLE OF SAME FOUR DISTINCTIVE COLORS ORBITTING PLANET EARTH IN SPATIOTEMPORAL FASHION WITHIN AND/OR ALONG THE LONGDITUDE AND LATITUDE COORDINATES OF FOUR EQUALLY SPACED CIRCULAR DESIGNED RINGS, wherefrom hereto collectively innate conception, terminological conveyance, indivisible rubric, syntactic oralformulaic, unique artwork, systematic arrangement, differentiated crafting, artistic construct, melodious lyrics, denominative literateness and thereat proprietary multiport revolving chambered binary hunting metallic track encasing hermetic lock up cast casing constrained unified real-time owned property of Juan Carlos Castro. Whereas, formation and establishment of a novel, unobvious, unique, unknown, unforeseen and unprecedented panacean cutting-edge novel, unobvious, unique, unknown, unforeseen and unprecedented technological innovation invoked within aforementioned UCMOST™ information technology is furthermore comprehensively suitable, generally pertinent and broadly useful innovative utility and design formulation hereby a heliocentrically identic rubricating pragmatic sanction and realistically existent innovative development and technological advancement whereby concretizing a new theater of operations and higher standards for an aforementioned efficient UNIVERSAL CAPITAL MARKET™ which is a necessarily integrated, critically important and increasingly integral aforementioned efficient UNIVERSAL ECONOMY™, wherefrom hereto collectively innate conception, terminological conveyance, indivisible rubric, syntactic oralformulaic, unique artwork, systematic arrangement, differentiated crafting, artistic construct, melodious lyrics, denominative literateness and thereat proprietary multiport revolving chambered binary hunting metallic track encasing hermetic lock up cast casing constrained unified real-time microprocessor machine language object block keyhole combinational software computer code heretofore and hereafter apprehends trademarks and service marks are exclusively owned property of Juan Carlos Castro. Whereas, moreover, it is undeniable and evidentiary findings of fact, documented reference, logical scientific reasoning and intuitive analytical reasoning that proprietary techniques, designs, systems, routines, devices, manners, modes, fashions, forms, formats, factors, objects, parts, segments, elements, components, constituents, ingredients, processes, methods and combinations of a novel, unobvious, unique, unknown, unforeseen and unprecedented universal currency denomination is also useful in commercializing formation and establishment of a novel, unobvious, unique, unknown, unforeseen and unprecedented UNIVERSAL CAPITAL MARKET™ in a necessarily integrated, critically important and increasingly integral aforementioned efficient UNIVERSAL ECONOMY™. The innovative technological solution invoked within aforementioned UCMOST™ information technology is comprehensively suitable, generally pertinent and broadly useful to combining every and all aforementioned PUBLIC FINANCIALS™ statements in connection with every and independently, autonomously, evidently, undeniably, logically, scientifically and intuitively the exclusive drivers of every and all transactional exchange initiatives, schemes, ocurrences, happenings, interactions, processes, methods, practices, movements, proceedings, messaging, presentations, notifications, filings, submissions, records, activities, actions, events, endeavors, tasks and affairs, and further are comprehensively suitable, generally pertinent and broadly useful to every and all aspects, topics, issues, matters, elements, components, functions, devices, software, systems, methods, combinations, processes and procedures of commercializing formation and establishment of a novel, unobvious, unique, unknown, unforeseen and unprecedented, ease of use and panacean cutting-edge aforementioned efficient UNIVERSAL CAPITAL MARKET™ for a necessarily integrated, critically important and increasingly integral aforementioned efficient UNIVERSAL ECONOMY™. Wherefrom aforementioned UCMOSTinformation technology are undeniably, respectively, independently, autonomously, evidently, undeniably, logically, scientifically and intuitively are comprehensively suitable, generally pertinent and broadly useful to every and all propriety software program applicationt, inclugive of without limitation, every and all the following: MYCASTER™; MYGLIDER™; MYTAXES™; MYTREASURE™; MYVOTE™; TRACKAIDE™; TRACKAUDIT™; TRACKCALENDAR™; TRACKCLOCK™; TRACKGAUE™; TRACKLAW™; TRACBETER™; TRACKPOINT™; TRACKPULSE™; TRACKSCHOOL™; TRACKSECURITY™; TRACKSHOW™; TRACKTRADE™; TRACKVIEW™; whereas, hereto collectively innate conception, terminological conveyance, indivisible rubric, syntactic oralformulaic, unique artwork, systematic arrangement, differentiated crafting, artistic construct, melodious lyrics, denominative literateness and thereat proprietary multiport revolving chambered binary hunting metallic track encasing hermetic lock up cast casing constrained unified real-time microprocessor machine language object block keyhole combinational software computer code heretofore and hereafter apprehends every and all, without limitation, aforementioned software programs application methods, proceses, titles, trademarks and service marks are exclusively owned intellectual properties of Juan Carlos Castro. Therefrom, it is undeniable and evidentiary findings of fact, documented formats, factors, objects, parts, segments, elements, components, constituents, ingredients, processes, methods and combinations of the novel, unobvious, unique, unknown, unforeseen, unprecedented, ease of use and panacean cutting-edge technological innovation invoked within aforementioned UCMOST™ information technology is furthermore comprehensively suitable, generally pertinent and broadly useful utility and design formulation herewith existent innovative developments and technological advancements useful to every and all aforementioned PUBLIC FINANCIALS™ statements inclusive of seamlessly and naturally wrapped, twisted, mixed, convoluted, embroidered and combined in connection with aforementioned PUBLIC FINANCIALS™ instruments from members of the aforementioned UNIVERSAL POPULACE™ which are undeniably, respectively, independently, autonomously, evidently, undeniably, logically, scientifically and intuitively the exclusive drivers of every and all transactional exchange initiatives, schemes, ocurrences, happenings, interactions, processes, methods, practices, movements, proceedings, messaging, presentations, notifications, filings, submissions, records, activities, actions, events, endeavors, tasks and affairs, which is further are comprehensively suitable, generally pertinent and broadly useful to every and all commercialized formation and establishment of a novel, unobvious, unique, unknown, unforeseen and unprecedented aforementioned efficient UNIVERSAL CAPITAL MARKET™ within a necessarily integrated, critically important and increasingly integral aforementioned efficient UNIVERSAL ECONOMY™. Thereupon, it is clearly an undeniable and evidentiary findings of fact, documented reference, logical scientific reasoning mnd intuitive analytical reasoning that every and all trademarks and/or services marks herein entailing, encompassing, comprising, involving, impacting and/or effecting every and all techniques, designs, systems, routines, devices, manners, modes, fashions, forms, formats, factors, objects, parts, segments, elements, components, constituents, ingredients, processes, methods and combinations of the streamlined, alternating scale, inseparable, seamless and natural wrapping, interlacing, coiling, coupling, combining and interlocking proprietary software graphical user interfaces, proprietary software application programs, proprietary software microprocessor computing systems, track encasing hermetic data link caster dart castings constrained new combinations which intrinsically incorporates and generally pertains to every and all conceived, engineered, designed and developed via constructive reduction to practice of aforementioned UCMOST™ information technology to completely resolve the tremendously long-held and enormously heart-felt unmet needs in the relevant art with original and independently devised copious works of art for programmed instruction entailing, encompassing, comprising, involving, impacting and/or effecting every and all one-time programmable read-only memory (PROM) of every and all computing central processing units (CPU) which is representative of, without limitation, every and all techniques, designs, systems, routines, devices, manners, modes, fashions, forms, formats, factors, objects, parts, segments, elements, components, constituents, ingredients, processes, methods and combinations of the novel unobvious, unique, unknown, unforeseen and unprecedented information technology herein conceived, engineered, designed and developed via constructive reduction to practice and hereafter useful, readily feasible for manufacturing and subsequent large-scale and wide-spread global licensing for sale as novel and unique products and services entailing, encompassing and comprirsing every and all techniques, designs, systems, routines, devices, manners, modes, fashions, forms, formats, factors, objects, parts, segments, elements, components, constituents, ingredients, processes, methods and combinations of the proprietary software graphical user interfaces, proprietary software application programs, proprietary software microprocessor computing systems, proprietary software streamlined procedural processes, proprietary novel business methods and proprietary multiport revolving chambered homing binary hunting metallic track encasing hermetic data link caster dart castings constrained new combinations which entail, encompass and comprise every and all of the preferred embodiments of aforementioned UCMOST™ information technology.

Whereas, MYCASTER™, wherefrom collectively innate conception, terminological conveyance, indivisible rubric, syntactic oralformulaic, unique artwork, systematic arrangement, differentiated crafting, artistic construct, melodious lyrics, denominative microprocessor machine language object block keyhole combinational software computer code heretofore and hereafter apprehends MYCASTER™, heretofore formally utilized proprietary trademark and/or service mark exclusively owned intellectual property of Juan Carlos Castro, is a software application that offers members of the aforementioned UNIVERSAL POPULACE™ with continuous spectrum single independent portal refractory real-time live and/or playback audio, video, sound, charactery, numismatic, grouped text and graphic imaging oriented digital-streaming broadcasting to supplant every and all, without limitation of the heretofore so-called wireline, wireless, network, toll booth, public access way, cable, radio, artificial satellite heretofore so-called communications propagating every and all aforementioned UNIVERSAL CAPITAL MARKET™ conceptual aid messaging, interactions, notifications, conversing, discourse, transmuting, traversing, conveying, accounting, communicating, transporting, energizing, reconciling, fueling, broadcasting, distributing and financing; whereas, MYCASTER™ is comprehensively suitable, generally pertinent and broadly useful to every and all data, information, character, numeric, audio, voice, sound, video, post, copy, graphic, design, figure, object, picture and/or image transmission casting and/or data, information, character, numeric, audio, voice, sound, video, post, copy, graphic, design, figure, object, picture and/or image transmission recovery propagating aforementioned efficient UNIVERSAL CAPITAL MARKET™ conceptual aids via aforementioned efficient UNIVERSAL CAPITAL MARKET communications via every and all, without limitation, portable rove beaing and/or fixtured rove bearing conduit mediums of effectuating aforementioned UCMOST™ real-time processinga and/or reprocessing via across-the-board traversal of all industrialized, developed and developing sovereign national borders within, throughout and transcending a never before seen, unique, novel, evidentiary, unobvious, unforeseen, unknown, unprecedented, hereafter clear, undeniable, logical, scientific and intuitive aforementioned efficient UNIVERSAL CAPITAL MARKET™ formed and established for a necessarily integrated and increasingly integral aforementioned efficient UNIVERSAL ECONOMY™.

Whereas, MYGLIDER™, wherefrom collectively innate conception, terminological literateness and thereat proprietary multiport revolving chambered binary hunting metallic track encasing hermetic lock up cast casing constrained unified real-time microprocessor machine language object block keyhole combinational software computer code heretofore and hereafter apprehends MYGLIDER™, heretofore formally utilized proprietary trademark and/or service mark exclusively owned intellectual property of Juan Carlos Castro, is a software application that offers members of the aforementioned UNIVERSAL POPULACE™ with continuous spectrum single independent portal refractory real-time live and/or playback to timely, reliable and secure advanced electronic locational systematizing geological and/or seismological processes concretizing innovative wheresoever transcendent EPROM, degauss and/or magnetostriction preemptively constrained ferromagnetic alloy, silicon, germanium, biodynamic and/or geomagnetic resonant soundproof and fireclay wall protective fireball impervious microcircuit epoxy casting insulated permeability of artificial semi-conducting microcircuit devices, articles, apparatuses, refractories and/or megastructures internalizing upright orthorhombic tentacular boundless steady state roving antennule transmuting metric conversional transistor transfusing receiver concretizing high-quality holistically steady state heliocentrically synchronizing ubiquitous hunting continuum parallel redundancy cosmos robotizing digitalized galactic transmitting receiver of spatiotemporal emitted broadcasting of real-time microprocessing traversing a single independent portal refractory evincing minutia partible iota beta particle trace element wave front continuous spectrum pulse signaling transmission conveying efficient energizing and fueling powered catalytic conduits via electrogasdynamics, electrogenesis, electrohydraulic, geomagnetic, gyromagnetic, geokinetic and/or thermodynamic setting transistorized rheostat regulated transfusing partible trace element staple actualizing galactic and/or intergalactic gyroscopic axisymmetrical stabilizing self-impetus protective contactor composite housing carriage hermetic cast lock up software encased unified real-time microprocessor machine language computer block for every and all portable and/or fixtured rove bearing articles, portable and/or fixtured rove bearing apparatuses and/or portable and/or fixtured rove bearing megastructures propagating traversal of every and all atmospheric access ways anytime, anywhere and anyplace. Whereas, MYTAXES™, wherefrom collectively innate conception, terminological conveyance, indivisible rubric, syntactic oralformulaic, unique artwork, systematic arrangement, differentiated crafting, artistic construct, melodious lyrics, denominative literateness and thereat proprietary multiport revolving chambered binary hunting metallic track encasing hermetic lock up cast casing constrained unified real-time microprocessor machine language object block keyhole combinational software computer code heretofore and hereafter apprehends MYTAXES™, heretofore formally utilized proprietary trademark and/or service mark exclusively owned intellectual property of Juan Carlos Castro, is a software application that offers members of the aforementioned UNIVERSAL POPULACE™ with continuous spectrum single independent portal refractory real-time live and/or playback to timely, reliable and secure payment of every and all town, locale, city, municipal, metropolis, county, district, province, state, federal, country, nation, transnational, multinational, transnational, federation and/or confederation governmental taxes which are assessed on every and all income and capital gains, inheritance inclusive of traversals and acquisition, leasing, operation, purchase, transferred and/or outright sale transactions of aforementioned PUBLIC FINANCIALS™ instruments from every and all individual members of the aforementioned UNIVERSAL POPULACE™ within, throughout and transcending the national sovereign borders of every and all industrialized, developed and developing free-market commerce and trade bloc economies within a single holistically econometric marketplace environment tabulated and calculated in real-time fashion anytime, anywhere and anyplace wherefrom payment transported daily to the applicable tax collecting governing membership aforementioned PUBLIC FINANCIALS™ organizations, wherefrom further tabulating, calculating and reporting daily, weekly, monthly, semi-monthly and annualized tax payments made to every and all town, locale, city, municipal, metropolis, county, district, province, state, federal, country, nation, transnational, multinational, transnational, federation and/or confederation governing governing membership aforementioned PUBLIC FINANCIALS™ organizations, thus eliminating every and all preconceived notions of so-called tax refunds and taxes liabilities past due and/or hereafter due. Whereas, MYTREASURE™, wherefrom collectively innate conception, terminological conveyance, indivisible rubric, syntactic oralformulaic, unique artwork, systematic arrangement, differentiated crafting, artistic construct, melodious lyrics, denominative literateness and thereat proprietary multiport revolving chambered binary hunting metallic track encasing hermetic lock up cast casing constrained unified real-time microprocessor machine language object block keyhole combinational software computer code heretofore and hereafter apprehends MYTREASURE™, heretofore formally utilized proprietary trademark and/or service mark exclusively owned intellectual property of Juan Carlos Castro, is a software application that offers members of the aforementioned UNIVERSAL POPULACE™ with continuous spectrum single independent portal refractory real-time live and/or playback to timely, reliable and secure treasuring monitoring services. Whereas, MYTREASURE™ offers members of the aforementioned UNIVERSAL POPULACE™ with updated data and/or information service filters which track and identify treasuring progress of below mentioned MYPOINI accumulation which serves as the sole medium of currency within, throughout and transcending the aforementioned efficient UNIVERSAL CAPITAL MARKET™ formed and established for a single econometric marketplace environment which entails, encompasses, comprises, involves, impacts and effects a necessarily integral and increasingly integrated aforementioned UNIVERSAL ECONOMY™. information to meet selective parameters. Whereas, MYTREASURE™ software application offers every and all members of the aforementioned UNIVERSAL POPULACE™ enhanced fairness, simultaneous equality, full transparency, best practices and best executions which continuously review and monitor update notifications of data and/or information pertaining to their appreciation and/or depreciation of treasuring which clearly, undeniably, logically, scientifically and intuitively involves every and all aspect of real-time accounting, communicating, transporting, energizing, fueling, broadcasting, distributing and financing throughout their lifetimes; whereas, hereto involve each and all aspects of their walk of life within, throughout and transcending their life work and/or existent participation within the aforementioned efficient UNIVERSAL ECONOMY™. Whereas, MYTREASURE™ is a software application allocation according to prefixed and/or and dynamically spontaneous randomly selected transactional exchange preferences, interests, strategies, objectives, risk tolerances and time horizons; whereas, entailing, encompassing, comprising, involving, impacting and effecting every and all transactional exchange initiatives, schemes, ocurrences, happenings, interactions, processes, methods, practices, movements, proceedings, messaging, presentations, notifications, filings, submissions, records, activities, actions, events, endeavors, tasks and affairs. Whereas, MYTREASURE™, is a software application which harnesses and leverages utilizing high-quality aforementioned UCMOST™ real-time processing and/or reprocessing processes in a timely, reliable and secure manner to improve every and all decision-making capabilities of members of the aforementioned UNIVERSAL POPULACE™. Whereas, furthermore, MYTREASURE™ software application offers automated real-time notification of relevant econometric data and/or information specific to every and all aforementioned PUBLIC FINANCIALS™ statements incorporating every and all aforementioned PUBLIC FINANCIALS™ instruments for real-time tracking selection analysis prior to and/or subsequent to exchanging every and all such potential econometric matching, clearing, executing, settling and exchanging within, throughout and transcending the aforementioned UNIVERSAL CAPITAL MARKET™. Whereas, moreover MYTREASURE™ is a staple software application which offers members of the aforementioned UNIVERSAL POPULACE™ real-time access to an automated solution for tracking every and all deposit inflow of numeric currency aforementiond MYPOINT™ generation from every and all sources which ensures their livelihood, lifeline and walk of life functions throughout their lifetimes, irrespective of whether such accumulation and necessary life style spending depreciation is premised on point wage earnings distributions for work unit services or from any one of a number of deferred entitlement and/or deferred retirement accounts, from the capital gains earned from the sale of PUBLIC FINANCIALS™ instruments, from the sale of every and all property inclusive of tracking every and all claims against aforementioned MYPOINT™ applied against the aforementioned multifaceted, multidimensional and in many cases staggered deposit accumulations of MYPOINT™ currency denominations from expenses whether behavioral expenses on demand wherefrom aforementioned monetary currency dollar denominations are evinced due at any one instant and moment in time or whether invoice bills for such incurred goods, products, services and supplies are due in delayed fashion via contractual agreeements relative to every and all sources of deposit accumulations and/or devalutions via claims against aforementioned MYPOINT™, wherefrom hereto ensuring their perpetual livelihood is carried out with utmost easy of use, simplicity, security, reliability, verifiability, transparency, comprehensiveness and understandability and assurance MYPOINT™ claims made seamlessly against every and all accumulated MYPOINT™ inflow whether such expenses pertain to basic life sustenance amenities such as payment for food and beverages, payments for hygiene and janitorial goods, products, services and supplies, payments for child rearing goods, products, services and supplies, payments for clothing and apparel, payment for automobile, housing rent and/or mortgage, payment for insurance coverages for life, health, property and casualty, death and disabilities, automobile, housing rent and/or mortage general liabilities, payment for every and all utilities in the forms of energy power, water and sewer, communications, payments for norminal town, city, municipal, district, province, state, federal, country, nation, transnational, multinational, transnational, federation and/or confederation glider drivers, operational and/or professional licenses, taxes, rates, assessments, charges, fees, tariffs, sur-charges inclusive of civil and commercial charges, fees for every and all residual and/or spontaneous public transport way vehicle energy power, vehicle acquisitions and upkeep inclusive of every and all residual and/o spontaneous transport access way sur-charges to/from every and all destinations within a single holistically econometric marketplace environments whether via gliders, automobiles, busing vehicles, rail-lines, watercraft vessels and/or aircrafts, payments to clear every and all executive, legislative and judicial fees, judicial sur-charges, payments for every and all health and prescription drugs, payments for every and all educational expenses inclusive of residual room and board, residual tuition, spontaneous books and supplies, payments for every and all other related to clear public and private debts inclusive of every and all payments for prefererencial dwelling acquisition, construction, development, expansion and upkeep, payments for nutritional, health and fitness recreational goods, products, all work productivity office station goods, products, services and supplies all of which are essential components and ingredients incurred as a by-product of maintaining a lifestyle within a civilized societal setting wherefrom hereto facilitating streamlined efficient and effective payment processing, tracking, review and analysis anytime, anyplace and anywhere within the aforementioned efficient UNIVERSAL CAPITAL MARKET™. Whereas, furthermore MYTREASURE™ is a software application accesses across-the-board traversal of every and all distributing and heretofore debt monitoring service which continuously tracks individual portfolio MYPOINT™ positions premised on accumulations and/or devalutions premised on transactional exchanging of aforementioned PUBLIC FINANCIALS™ instruments in real-time offering real-time aforementioned integrated aforementiond PUBLIC FINANCIALS™ statements incorporating every and all accumulations and/or devaluations of MYPOINT™ totals in real-time and/or historically. Wheras, MYTREASURE™ is a software application which scans the aforementioned efficient UNIVERSAL CAPITAL MARKET™ theater of operations related to every and all accounting, communicating, transporting, energizing, fueling, broadcasting, distributing and financing clearly, undeniably, logically, scientifically and intuitively entailing, encompassing, comprising, involving, impacting and effecting matching, clearning, executing, settling and exchanging issues incorporating every and all jurisprudential adjusdiations, findings, bankruptcy and dissolvement, alimony, child care, educational, travel, recreations, sightseeing and/or pleasure seeking transactional exchange initiatives, schemes, ocurrences, happenings, interactions, processes, methods, practices, movements, proceedings, messaging, presentations, notifications, filings, submissions, records, activities, actions, events, endeavors, tasks and affairs; Whereas, MYTREASURE™, holistically eliminates and heliocentrically eradicates every and all heretofore preconceived irrational. obscurant, feckless, malicious, mendacious, oppressing, confusing and misleading so-called interest rate, discount rate and/or foreign exchange rate fluctuations to ensure continuous spectrum equalizing in real-time of every and all assize rubric identic pragmatic sanction MYPOINT™ exchange rate parity entailing, encompassing, comprising, involving, impacting and effecting every and all aforementioned PUBLIC FINANCIALS™ software application sources, identifies, and relays real-time changing accumulations, devaluations, prefix adjustments, spontaneously random inflows and/or outflows of MYPOINT™ plans, goals, objectives, tolerances and short/long-term time horizons.

Whereas, MYVOTE™, wherefrom collectively innate conception, terminological conveyance, indivisible rubric, syntactic oralformulaic, unique artwork, systematic arrangement, differentiated crafting, artistic construct, melodious lyrics, denominative literateness and thereat proprietary multiport revolving chambered binary hunting metallic track encasing hermetic lock up cast casing constrained unified real-time microprocessor machine language object block keyhole combinational software computer code heretofore and hereafter apprehends MYVOTE™, heretofore formally utilized proprietary trademark and/or service mark exclusively owned intellectual property of Juan Carlos Castro, is a software application that offers 24-hours a day, 7-days a week access to, without limitation, everya and all timely, reliable, secure, verifiable, transparent, never faulting, never failing, comprehensive and understandable real-time elective registration and voting requisites anytime, anywhere and anyplace within, throughout and transcending the geographical territories of a single holistically econometric marketplace environment. is a software application which offers members of the aforementioned IYERSAL POPULACE™ with continuous spectrum single independent portal refractory real-time live and/or playback audio, video, sound, charactery, numismatic, grouped text and graphic imaging oriented digital-streaming broadcasting to supplant every and all, without limitation of the heretofore so-called wireline, wireless, network, voting booth, jurisdicational station, toll. booth, public access way, cable, radio, artificial satellite heretofore so-called communications propagating every and all aforementioned UNIVERSAL CAPITAL MARKET™ conceptual aid messaging, interactions, notifications, conversing, discourse, transmuting, traversing, conveying, voting, tabulating, accounting, communicating, transporting, energizing, reconciling, fueling, broadcasting and distributing to ensure MYVOTETM offers enhanced fairness, simultaneous equality, full transparency, consolidated acess, best practices and best execution related to every and all forms and jurisdictions related to public voting voting data and/or information services which track and identify real-time voting tabulations which meet the specific parameters of aforementiond UCMOST™ information technologies, whereby supplanting every and all heretofore so-called manual, proxy and/or absentee voter balloting and/or tabulating which is hererto completely antiquated, archaic, ancient history and superannuated methodology which is increasingly debilitating and detrimental to the accuracy, security, reliability, accessibility, comprehensiveness, transparency and understandability of every and all forms of voting methodology related to every and all, without limitation, members of the aforementioned PUBLIC FINANCIALS™ organizations inclusive of, without limitation, every and all members of the aforementioned UNIVERSAL POPULACE™. Whereas, furthermore MYVOTE™, software application enables members of the aforementioned UNIVERSAL POPULACE™ to continuously review and monitor real-time data and/or information on elective voting. Whereas, MYVOTE™, data and/or information is to include, without limitation, elective ballot registration and propagation volumes in real-time data and/or information whereby simultaneously and equally empowering everya and all, without limitation, members of the aforementioned UNIVERSAL POPULACE to submit their voting preferences, and instantaneously review and analyze their respective votes for apportionment, financing, reapportionment, amendment and/or representational governance legislative propagation.

Whereas, TRACKAIDE™, wherefrom collectively innate conception, terminological conveyance, indivisible rubric, syntactic oralformulaic, unique artwork, systematic arrangement, differentiated crafting, artistic construct, melodious lyrics, denominative literateness and thereat proprietary multiport revolving chambered binary hunting metallic track encasing hermetic lock up cast casing constrained unified real-time microprocessor machine language object block keyhole combinational software computer code heretofore and hereafter apprehends TRACKAIDE™, heretofore formally utilized proprietary trademark and/or service mark exclusively owned intellectual property of Juan Carlos Castro, is a software application which offers members of the aforementioned UNIVERSAL POPULACE™ with 24-hour a day, 7-days a week access UNIVERSAL POPULACE™ on prospective portfolio fund allocations relative to current holdings, economic meters, historical risk/return ratios, securities ratio analytics and prudent transactional exchange management techniques, theories, models and forecasts. This software application enables retail and institutional members of the aforementioned UNIVERSAL POPULACE™ to quickly access historical risk/return profiles for specific asset classes and/or specific securities. The members of the aforementioned UNIVERSAL POPULACE™ access and utilize this decision-modeling financial risk management software application to keep abreast of new decision-modeling techniques, advances in financial theories, changes in the legal, regulatory, financial, accounting, and auditingdscape, and other businessdscape issues that positively affect the latest version of our software application. TRACKAIDE™ is seamlessly integrated to real-time and historical financial instrument price quotations and exchange valuations which offer richly enlightening and high-quality valuable real-time data and/or information. Moreover, TRACKAIDE™, is a software application which offers members of the aforementioned UNIVERSAL POPULACE™ with 24-hour a day, 7-days a week access to comprehensive coverage of mutual, index and basket funds managed in active and passive automation by professional transactional exchange management companies or listed on a market exchange. This software application facilitates diverse financial queries and analytical strategies that enable members of the aforementioned UNIVERSAL POPULACE™ to identify and select multiple funds to create an actively and passively managed, index fund, hedge fund, and basket transactional exchange portfolio, including, without limitation, any combination or hybrid thereof. This software application enables full-scale technical charting, analysis and risk management decision-modeling thereby enabling members of the aforementioned UNIVERSAL POPULACE™ to conduct thorough due diligence and feasibility analysis prior to making financial and/or transactional exchange decision. This software application compares multiple transactional exchange managers and mutual funds against style and drift static indices within a risk/return profile graph enabling members of the aforementioned UNIVERSAL POPULACE™ to forecast prospective scenarios using the decision-modeling capability. Whereas, TRACKALDE™ offers members of the aforementioned UNIVERSAL POPULACE™ an opportunity to execute an exchange transaction for specific funds or a basket of funds. This software application enables members of the aforementioned UNIVERSAL POPULACE™ to make well informed, objective and self-assured financial and transactional exchange decisions. This software application displays fund management expenses, administrative costs, clearing and brokerage commissions, custodian fees, sales, promotional marketing, and distribution, so-called (12b-1) charges, and other administrative expenses. Whereas, TRACKAIDE™, software application also offers members of the aforementioned UNIVERSAL POPULACE™ a comparative analytical method of acquiring net costs before making an transactional exchange decision involving mutual, index or hedge funds by facilitating a real-time two-dimensional, visual graphic presentation of transactional exchange patterns, trends and analysis involving every and all aforementioned PUBLIC FINANCIALS™ instruments. Whereas, TRACKAIDE™ offers real-time audio-visual graphics and/or images presented to members of the aforementioned UNIVERSAL POPULACE™ offers a dynamnic of market movements on every and all products, goods, services and/or supplies in a color-coded, graphical and schematic presentation of particular industries and sectors. Whereas, TRACKAIDE™ is a software application which incorporates double-click functions that connect members of the aforementioned UNIVERSAL POPULACE™ to particular sectors and industries to view which specific underlying aforementioned PUBLIC FINANCIALS™ instruments are actively traded within, throughout and transcending the aforementioned efficient UNIVERSAL CAPITAL MARKET™. Whereas, furthermore TRACKAIDE™ is a software application which incorporates multidimensional services to enable members of the aforementioned UNIVERSAL POPULACE™ to visualize and/or monitor any form of data and/or information, and/or statistics which trace the origin of all such, real-time movements and/or point valuations.

Whereas, TRACKAUDIT™, wherefrom collectively innate conception, terminological conveyance, indivisible rubric, syntactic oralformulaic, unique artwork, systematic arrangement, differentiated crafting, artistic construct, melodious lyrics, denominative literateness and thereat proprietary multiport revolving chambered binary hunting code heretofore and hereafter apprehends TRACKAUDIT™, heretofore formally utilized proprietary trademark and/or service mark exclusively owned intellectual property of Juan Carlos Castro, is a software application which concretizes real-time automatizing perpetual, random, consistent and real-time internal, external and independent auditing capabilities in aforementioned UCMOST™ information technology wherein every and all of the tens of thousands members of the aforementioned UNIVERSAL POPULACE™ and hundreds of millions members of the aforementioned UNIVERSAL POPULACE™ to ensure that every and all of their seamless and natural wrapped, twisted, convoluted, seamlessly and naturally wrapped, twisted, mixed, convoluted, embroidered and combined aforementioned PUBLIC FINANCIALS™ statements inclusive of seamlessly and naturally wrapped, twisted, mixed, convoluted, embroidered and combined in connection with aforementioned PUBLIC FINANCIALS™ instruments inclusive of every and all of their seamless and natural wrapped, twisted, convoluted, seamlessly and naturally wrapped, twisted, mixed, convoluted, embroidered and combined quotation, matching, clearance, execution, settlement and exchange of insurance, risk financing, credit, cash management, investment banking and aforementioned PUBLIC FINANCIALS™ instruments transactional exchange data with aforementioned PUBLIC FINANCIALS™ instruments transactional exchange information is in steadfast adherence and full compliance to every and all members of the aforementioned UNIVERSAL POPULACE™, and penal, statutory, contract and/or tort laws, governing rules and authoritative regulations. TRACKAUDIT™ is conceived, engineered, designed and developed via constructive reduction to practice to ensure that streamlined, alternating scale, inseparable, seamless and natural wrapping, interlacing, coiling, coupling, combining and interlocking of an internal albeit independent auditing software mechanism is concretizing in every and all techniques, designs, systems, routines, devices, manners, modes, fashions, forms, formats, factors, objects, parts, segments, elements, components, constituents, ingredients, processes, methods and combinations within aforementioned UCMOST™ information technology to ensure that every and all the tens of thousands members of the aforementioned UNIVERSAL POPULACE™ and hundreds of millions members of the aforementioned UNIVERSAL comprehensiveness, understandability and assurance are comprehensively suitable, generally pertinent and broadly useful entailing, encompassing, comprising, involving, impacting and/or effecting automatizing real-time holistically steady state synchronized ubiquitous continuum real-time rhombus microprocessing instantaneous transmission and receiver transforming traverse conduit aforementioned UCMOST™ real-time processing and/or reprocessing of every and all aforementioned PUBLIC FINANCIALS™ statements inclusive of, without limitation, every and all order-entry quotation, matching, clearance, execution, settlement and exchange of insurance, risk financing, credit, cash management, investment banking and aforementioned PUBLIC FINANCIALS™ instruments to instill requiste perpetual, random, consistent, internal, external and independent auditing capabilities ensuring steadfast adherence and full compliance to full disclosure, best practices, best executions, enhanced fairness, simultaneous equality, full transparency, consolidated access and perpetual integration members of the aforementioned UNIVERSAL POPULACE™ inclusive members of the aforementioned UNIVERSAL POPULACE™ comprehensively suitable, generally pertinent and broadly useful to the accuracy, quality, integrity, honor, timeliness, relevance, transparency, reliabilty, verifiability, comprehensiveness, understandability and assurance of every and all real-time processing and/or reprocessing of data and/or information receiver invoked via aforementioned UCMOST™ information technology within an aforementioned efficient UNIVERSAL CAPITAL MARKET™ for an necessarily integrated, critically important and increasingly integral aforementioned efficient UNIVERSAL ECONOMY™.

Whereas, TRACKCALENDAR™, wherefrom collectively innate conception, terminological conveyance, indivisible rubric, syntactic oralformulaic, unique artwork, systematic arrangement, differentiated crafting, artistic construct, melodious lyrics, denominative literateness and thereat proprietary multiport revolving chambered binary hunting metallic track encasing hermetic lock up cast casing constrained unified real-time microprocessor machine language object block keyhole combinational software computer code heretofore and hereafter apprehends TRACKCALENDAR™, heretofore formally days a week access to timely, reliable and secure universal calendar comprehensively suitable, generally pertinent and broadly useful to supplant the premise of the superannuated solar calendar heretofore arbitrarily sponsored by Pope Gregory XIII in 1582 to correct then antiquated, archaic, ancient history and superannuated Julian calendar, where from TRACKCALENDAR™ is comprehensively suitable, generally pertinent and broadly useful to every and all personal, proprietary, partnership company, firm, corporation, incorporation, commercial, franchise, union, thrift, group, board, institute, convention, bi-cameral, society, chamber, not-for-profit, foundation, endowment, association, league, consortium, commission, agency, bureau, department, court, embassy, section, town, locale, city, municipal, metropolis, county, district, province, state, federal, country, nation, transnational, multinational, transnational, federation and/or confederation hereto comprehensively apprehending every and all members of the aforementioned PUBLIC FIANANCIALS™ organizations inclusive of, without limitation, every and all individual members of the aforementioned UNIVERSAL POPULACE™. Whereas, aforementioned TRACKCALENDAR™ is an extremely accurate, never faulting, never falling, never adjusting, verifiable, timely, consistent, reliable, transparent, logical, comprehensive and understandable reality premised on a 2,500 year old findings of a Metonic cycle lunar month and 12 lunar month year in which the time between successive new and/or full moons is nearly equal to 29 days, 12 hours and 44 minutes; wherefrom, it is a clearly undeniable and evidentiary findings of fact, documented reference, logical scientific deduction and intutive analytical reasoning that each Metronic cycle evinces an elapsing period of time approximating nineteen years of 235 dynamically cyclical lunar months, however evincing an exactly similar natural order and seamless pattern of cyclical phase rotation thereafter for ages and ages without any heretofore disparate erratic, confusing and misunderstood so-called solar month and/or so-called leap-year adjustments; whereas, moreover useful within, throughout and transcending the national sovereign borders of every and all industrialized, developed and developing free-market commerce and trade bloc economies within a single holistically econometric marketplace environment concretizing real-time lunar cycle tabulating and calculating ubiquotous hunting initiative movements effectuated in real-time, wherefrom further tabulating, calculating and reporting daily, weekly, monthly, tri-monthly and annualized calendar date movements, thus supplanting every and all preconceived notions of heretofore fragmenting and heretofore disparate International Date Standards (IDS).

Whereas, TRACKCLOCK™, wherefrom collectively innate conception, terminological conveyance, indivisible rubric, syntactic oralformulaic, unique artwork, systematic arrangement, differentiated crafting, artistic construct, melodious lyrics, denominative literateness and thereat proprietary multiport revolving chambered binary hunting metallic track encasing hermetic lock up cast casing constrained unified real-time microprocessor machine language object block keyhole combinational software computer code heretofore and hereafter apprehends TRACKCLOCK™, heretofore formally utilized proprietary trademark and/or service mark exclusively owned intellectual property of Juan Carlos Castro, is a software application which offers members of the aforementioned UNIVERSAL POPULACE™ 24-hour a day, 7-days a week access to a timely, reliable and secure universal clockwise timepiece comprehensively suitable, generally pertinent and broadly useful to every and all hereto comprehensively apprehending every and all assize individual members of the aforementioned UNIVERSAL POPULACE™ within, throughout and transcending the national sovereign borders of every and all industrialized, developed and developing free-market commerce and trade bloc economies within a single holistically econometric marketplace environment via explicitly supplanting the inefficient, ineffective, hesitant, dividing, fragmenting, restricting, obfuscasting, antiquated, archaic, ancient history and superannuated so-called atomic clock located in Greenwich, England, via spatiotemporal hunting traversing all heretofore veiled, inefficient, ineffective, antiquated, archaic, ancient history and superannuated 24 longitudinal geologic divisions which obstruct a single global econometric clockwise timepiece marketplace environment, hereafter concretizing ubiquotous hunting synchronizing parity of real-time spatiotemporal clockwise timepieces anytime, anywhere and anyplace propagating real-time, daily, weekly, monthly, and/or annualized geological and geophyics entailing, encompassing, every and all preconceived notions of heretofore fragmented and unconsolidated spatiotemporal clockwise matters, issues, events, occurrences, transpiring, happening, happenstance and movements; whereas, aforementioned TRACKCLOCK™ evinces an extremely accurate, never faulting, never failing, never adjusting, verifiable, timely, consistent, reliable, transparent, logical, comprehensive and understandable reality premised on a 2,500 year old findings of a Metonic cycle lunar month and 12 lunar month year in which the time between successive new and/or full moons is nearly equal to 29 days, 12 hours and 44 minutes; wherefrom, it is a clearly undeniable and evidentiary findings of fact, documented reference, logical scientific deduction and intutive analytical reasoning that each Metronic cycle evinces an elapsing period of time approximating nineteen years of 235 dynamically cyclical lunar months, however evincing an exactly similar natural order and seamless pattern of cyclical phase rotation thereafter for ages and ages without any heretofore disparate so-called daylight savings solar month and/or solar year erattic, confusing and misunderstood lagging adjustments.

Whereas, TRACKGAUGE™, wherefrom collectively innate conception, terminological conveyance, indivisible rubric, syntactic oralformulaic, unique artwork, systematic arrangement, differentiated crafting, artistic construct, melodious lyrics, denominative literateness and thereat proprietary multiport revolving chambered binary hunting metallic track encasing hermetic lock up cast casing constrained unified real-time microprocessor machine language object block keyhole combinational software computer code heretofore and hereafter apprehends TRACKGAUGE™, heretofore formally utilized proprietary trademark and/or service mark exclusively owned intellectual property of Juan Carlos Castro, is a software application which offers members of the aforementioned UNIVERSAL POPULACE™ access to a decision-modeling accounting and financial reporting risk management service in real-time thus enabling an innovative process of monitoring, tracking and/or analyzing econometric reporting decisions prior to taking action or booking the dart trace into the ledger balance accounts which continuously disseminate statutorily required statements inclusive of data and/or information from all members of the aforementioned UNIVERSAL POPULACE™. general accounting entries, adjustments, revisions, restatements, reclassifications, and other cumulative interpretations recognized as standard across industries and sectors of the economies of most sovereign nations. Whereas, TRACKGAUGE™ software application offers real-time decision-modeling capabilities that efficiently and effectively graphically displays accounting decisions and/or chart trace entries which inherently and/or intrinsically raise red flags. Whereas, moreover, TRACKGAUGE™ software application anticipates the need to work closely with numerous and very powerful organizations to accomplish its task of developing this real-time decision-modeling and real-time risk-managed innovative development and technological advancement.

Whereas, TRACKLAW™, wherefrom collectively innate conception, terminological conveyance, indivisible rubric, syntactic oralformulaic, unique artwork systematic arrangement, differentiated crafting, artistic construct, melodious lyrics, denominative literateness and thereat proprietary multiport revolving chambered binary hunting metallic track encasing hermetic lock up cast casing constrained unified real-time microprocessor machine language object block keyhole combinational software computer code heretofore and hereafter apprehends TRACKLAW™, heretofore formally utilized proprietary trademark and/or service mark exclusively owned intellectual property of Juan Carlos Castro, is a software application which offers members of the aforementioned UNIVERSAL POPULACE™ and senior executives with 24-hour a day, 7-day a week access to governmental, regulatory and legal developments that may affect members of the aforementioned UNIVERSAL POPULACE™ and members of the aforementioned UNIVERSAL POPULACE™ across multiple sectors and industries. This software application offers members of the aforementioned UNIVERSAL POPULACE™ comprehensive legal consulting, estate planning and organizational development topics, issues and items to maximize knowledge and utilization of legal instruments in establishing and securing business and estate continuation plans via an integrated worldwide network of law practices. This software application educates members of the aforementioned UNIVERSAL POPULACE™ on how to develop and implement a customizable, risk-managed and suitable business and/or personal estate services, and facilitates development of designated estate trustee, in accordance with the family needs, risk tolerances, time horizons, transactional exchange expectations and legal objectives.

Whereas, TRACKMETER™, wherefrom collectively innate conception, terminological conveyance, indivisible rubric, syntactic oralformulaic, unique artwork, systematic arrangement, differentiated crafting, artistic construct, melodious lyrics, denominative literateness and thereat proprietary multiport revolving chambered binary hunting metallic track encasing hermetic lock up cast casing constrained unified real-time microprocessor machine language object block keyhole combinational software computer code heretofore and hereafter apprehends TRACKMETER™, heretofore formally utilized proprietary trademark and/or service mark exclusively owned intellectual property of Juan Carlos Castro, is a software application which offers members of the aforementioned UNIVERSAL POPULACE™ and members of the aforementioned UNIVERSAL POPULACE™ with 24-hour a day, 7-day a week access to real-time tracking of every and all, without limitation, accounting tracemeter, communicating tracemeter, transporting tracemeter, energizing tracemeter, fueling tracemeter, broadcasting tracemeter, distributing tracemeter and financing tracemeter, inclusive of, without limitation, every and all forms of heretofore energizing megawatt, powering megahertz and/or fueling megatransport meter readings entailing, encompassing, comprising, involving, impacting and effecting the hereafter efficient, effective, functional and integrated forms of accounting, communicating, transporting, energizing, fueling, broadcasting, distributing and financing related aforementioned PUBLIC FINANCIALS™ instruments. Whereas, TRACKMETER™ software application also incorporates every and all forms, parts, methods, devises, plans and/or devices whether involving residential, commercial, national and/or transnational government rubric pragmatic sanction appliances, products, goods, services and/or supplies, thereof which are hereto clearly, undeniably, logically, scientifically and intuitively one and the same aforementioned PUBLIC FINANCIALS™ instruments whether tangible and/or intangible, which are made available to members of the aforementioned UNIVERSAL organizations which are legitimately authorized, commissioned and made available and/or accessible within, throughout and transacending the national sovereign so-called borders of industrialized, developed and developing free-market commerce and trade economies without, throughout and transcending the aforementioned efficient UNIVERSAL CAPITAL MARKET™.

Whereas, TRACKPOINT™, wherefrom collectively innate conception, terminological conveyance, indivisible rubric, syntactic oralformulaic, unique artwork, systematic arrangement, differentiated crafting, artistic construct, melodious lyrics, denominative literateness and thereat proprietary multiport revolving chambered binary hunting metallic track encasing hermetic lock up cast casing constrained unified real-time microprocessor machine language object block keyhole combinational software computer code heretofore and hereafter apprehends TRACKPOINT™, heretofore formally utilized proprietary trademark and/or service mark exclusively owned intellectual property of Juan Carlos Castro, is a charactery and/or numismatic application of software article which offers individual members of the aforementioned UNIVERSAL POPULACE™ steadfast and utmost full disclosure, best practices, best executions, enhance fairness, simultaneous equality, full transparency, consolidated access and perpetual integration to assize propagating, proclaiming and promulgating syntactic didactic transfiguration synthesis transnational identic transmuting atmospheric and/or translunar rubric pragmatic sanction; hermetically independent, holistically interoperable, heliocentrical object interlocking and inifinitely unified accuracy, quality, integrity, honor, timeliness, relevance, transparency, reliabilty, verifiability, comprehensiveness, understandability and assurance of digitalized charactery and/or numismatic driven econometric system linear bi-directional under flow color constrained negative (red) and postive (gold) singular non-decimalized charactery and/or numismatic universal point currency (etc.; −3; −2; −1=0+0=+1; +2; +3; etc.); whereas comprising every and all wage laborious earnings and/or income, capital gains, toll collection, tax collection, market valuation, depreciation, appreciation, goodwill and/or intangible propetery values; whereform hereto terminological denominated syntactic synthesis evincing universal registered legal efficient, holistically effective and infinitely coinless and/or paper-less universal contactor currency accessible anywhere, anytime, anyplace via conceptual aids whereas retrieved and/or transmitted in real-time via every and all conduit articles of UNIVERSAL CAPITAL MARKET™ communications leveraging and harnessing the rich powers of unified real-time microprocessing capacities of UCMOST™; whereas TRACKPOINT™ econometric system is innately, inherently and intinsically as a pragmatic sanction rubric utilized by every and all members of the aforementioned PUBLIC FINANCIALS™ organizations, inclusive of, without limitation, every and all individual members of the aforementioned UNIVERSAL POPULACE™ to propagate, proclaim and promulgate every and all legal exchange, without limitation, of aforementioned PUBLIC FINANICALS™ instruments entailing, encompassing, comprising, involving, impacting and/or effecting every and all products, goods, services and supplies embroidered within the aforementioned efficient UNIVERSAL CAPITAL MARKET™; wherefrom TRACKPOINT™ econometric universal currency comprehensively suitable, generally pertient and broadly useful within, throughout and transcending the national sovereign so-called borders of every and all industrialized, developed and developing free-market commerce and trade bloc economies embodying geographical territories of a single holistically econometric marketplace comprising in it's infnitely melioristc entirety an aforementioned efficient UNIVERSAL ECONOMY™; hereto belonging philosophically; theoretically, logically, scientifically and intuitively to the aggregate composite mass of living and breathing human organisms embodying the grace of a supreme creator of the universe; wherefrom evincing the individual members of the aforementioned UNIVERSAL POPULACE™.

Whereas, TRACKPULSE™, wherefrom collectively innate conception, terminological conveyance, indivisible rubric, syntactic oralformulaic, unique artwork, systematic arrangement, differentiated crafting, artistic construct, melodious lyrics, denominative literateness and thereat proprietary multiport revolving chambered binary hunting metallic track encasing hermetic lock up cast casing constrained unified real-time microprocessor machine language object block keyhole combinational software computer Juan Carlos Castro. Whereas, TRACKPULSE™ is a software application offers members of the aforementioned PUBLIC FINANCIALS™ organizations real-time multifaceted and multidimensional access to an automated corporate intelligence information econometric tracking solution which is entirely capable of instantaneously downplaying misstatements, false statements, misleading annecdotes, innuendoes, and incorrect speculative and/or surprising analyses and is comprehensively suitable, generally pertinent and broadly useful to the industry movements, trends, forecasts and on-going activities of all industries and sectors within, throughout and transcending the aforementioned efficient UNIVERSAL CAPITAL MARKET™. Whereas, TRACKPULSE™ is also a software application which integrates stealth mode corporate analysis screening of every and all aforementioned efficient UNIVERSAL CAPITAL MARKET™ conceptual aids propagated via every and all aforementioned efficient UNIVERSAL CAPITAL MARKET™ communication mediums, articles, apparatuses and/or megastructures. Whereas, TRACKPULSE™ is a software application which becomes an ultra-sophisticated corporate intelligence monitoring device that incorporate utilization of audio, video, character, numeric, text, design and graphics forms of financial statements and non-financial public information. Whereas, TRACKPULSE™ strives to protect the so-called market capitalizations, cost of capital inclusive of, without limitation, the sustenance of so-called cash liquidity, financial solvency and economic stability within the aforementioned efficient UNIVERSAL CAPITAL MARKET™. Whereas, TRACKPULSE™, is also a software application which automatically informs senior executives of tempestuous exponentially detrimental and/or tempestuous exponentially debilitating financial and non-financial public information to enable effective submission of official replies directly to the source of the problem and on the members of the aforementioned UNIVERSAL POPULACE™. Whereas, TRACKPULSE™, offers real-time automated corporate intelligence monitoring which eradicates any form of reliance and/or credibility on tainted manually gathered data and/or information, wherefrom enabling real-time senior executive prefix disseminated replies to a multitude of licensed data and/or information service providers to rapidly mitigate any false belief, misstatements, innuendoes, misrepresentations, outright false risk management tool incorporating real-time corporate intelligence monitoring capability to assist aforementioned PUBLIC FINANCIALS™ organizations to sustain capitalization and protect the cost of capital.

Whereas, TRACKSCHOOL™, wherefrom collectively innate conception, terminological conveyance, indivisible rubric, syntactic oralformulaic, unique artwork, systematic arrangement, differentiated crafting, artistic construct, melodious lyrics, denominative literateness and thereat proprietary multiport revolving chambered binary hunting metallic track encasing hermetic lock up cast casing constrained unified real-time microprocessor machine language object block keyhole combinational software computer code heretofore and hereafter apprehends TRACKSCHOOL™, heretofore formally utilized proprietary trademark and/or service mark exclusively owned intellectual property of Juan Carlos Castro, is a software application which offers members of the aforementioned UNIVERSAL POPULACE™ with 24-hours a day, 7-days a week access to a real-time educational market simulation of buying and selling securities, mutual funds, option contracts, commodity trading instruments, hedge funds and futures contracts utilizing full-scale portfolio management capabilities. Wheras, furthermore, TRACKSCHOOL™ is a software application which serves as an entertainment and educational requisite forum to assist members of the aforementioned UNIVERSAL POPULACE™ in learning the ease of use methodologies and simplified processes utilized in developing real-time treasuring and distributing management skills and techniques to manage risk within an aforementioned efficient UNIVERSAL CAPITAL MARKET™. Whereas, TRACKSCHOOL™ is a software application affords members of the aforementioned UNIVERSAL POPULACE™ simulated input order-entry capabilities enabling them to actually feel “as if” they are effectuating and experiencing the economic effects of financial and transactional exchange decisions within an aforementioned efficient UNIVERSAL CAPITAL MARKET™. This software application offers knowledge of real-time financial risk management theories, models, skills and techniques utilized to manage cash and securities positions within an aforementioned efficient UNIVERSAL CAPITAL MARKET™. Whereas, real-time risk management skill capabilities to assist themselves in making suitable econometric transactional exchanging decisions.

Whereas, TRACKSECURITY™, wherefrom collectively innate conception, terminological conveyance, indivisible rubric, syntactic oralformulaic, unique artwork, systematic arrangement, differentiated crafting, artistic construct, melodious lyrics, denominative literateness and thereat proprietary multiport revolving chambered binary hunting metallic track encasing hermetic lock up cast casing constrained unified real-time microprocessor machine language object block keyhole combinational software computer code heretofore and hereafter apprehends TRACKSECURITY™, heretofore formally utilized proprietary trademark and/or service mark exclusively owned intellectual property of Juan Carlos Castro, is a software application which offers members of the aforementioned UNIVERSAL POPULACE™ with 24-hours a day, 7-days a week access to an automated solution for shopping, selecting and acquiring every and all real-time processing and/or reprocessing of data and/or information receiver related to every and all obscurant, irresponsible, feculent, irrational, feckless, disrespectful, mendacious, ignorant, malicious, condescending, untruthful, insolent, inefficient, incognizant, ineffective, fragmenting, unlettered, unpolished, presumptuous, portentous, pretentious, fruitless, disparate, antiquated, archaic, ancient history and superannuated so-called annuity, so-called life-insurance, so-called business errors and omissions, so-called director's and officer's, so-called key-person, so-called accidental death, so-called dismemberment, so-called disability, so-called workers compensation and so-called general liability insurance policies and/or so-called annuitizing contracts. This software application enables members of the aforementioned UNIVERSAL POPULACE™ to input specific details on their current and future assurance policies and assurance contracts to compare them effectively against newly available assurance policies and assurance contracts issued and offered in a single holistically econometric marketplace environment. Whereas, this software application is to become an integrated and comprehensive database of actuarial and underwriting market data and/or information to include, without limitation, industry standard risk-management guidelines that elicits Whereas, this software application offers insurance quotations tailored to the unmet needs and econometric plans, tax strategies and/or estate decrees.

Whereas, TRACKSHOW™, wherefrom collectively innate conception, terminological conveyance, indivisible rubric, syntactic oralformulaic, unique artwork systematic arrangement, differentiated crafting, artistic construct, melodious lyrics, denominative literateness and thereat proprietary multiport revolving chambered binary hunting metallic track encasing hermetic lock up cast casing constrained unified real-time microprocessor machine language object block keyhole combinational software computer code heretofore and hereafter apprehends TRACKSHOW™, heretofore formally utilized proprietary trademark and/or service mark exclusively owned intellectual property of Juan Carlos Castro, is a software application which offers members of the aforementioned UNIVERSAL POPULACE™ with 24-hours a day, 7-days a week access to an automated solution for shopping, selecting and acquiring every and all UCMOST™ real-time processing and/or reprocessing of data and/or information transmission broadcasting and/or transmission receiver of real-time data and/or information related to every and all musical, opera, play, drama, travesty, horror, tragedy, comedy, animation, action, porn, science-fiction and/or theatrical copious works of literary, theatrical, melodius, artistic, sporting, eductional, pleasure, recreational and entertainment audio, video, voice, visual, graphic and/or image compositions, productions, performances, solicitations, promotions, commercials, advertisements, promulgations and/or propagations entailing, encompassing, comprising, involving, impacting and/or effecting any of the following literary, melodius, artistic, sporting, eductional, recreational and/or entertainment media inclusive of, without limitation, street, street walking, street theater, off-off-Broadway, off-Broadway, radio network, network television, movie and radio, cinematic artificial satellite, cable, television and movie network cable, radio, television and movie network and artificial satellite radio, television and movie network of broadcast, distribution and syndication inclusive of rebroadcast, redistribution and resyndication from every and all members of the aforementioned UNIVERSAL POPULACE™ whichever every and all are furthermore undeniably, logically, UNIVERSAL POPULACE™ entailing, encompassing, comprising, involving, impacting and/or effecting every and all of the following: productions; programs; performances; documentaries; acts; plays; sitcoms; shows; games; realities; screen productions; screen programs; screen performances; screen documentaries; screen acts; screen plays; screen sitcoms; screen shows; screen games; screen realities; screen stage productions; screen stage programs; screen stage performances; screen stage documentaries; screen stage acts; screen stage plays; screen stage sitcoms; screen stage shows; screen stage games; screen stage realities; screen stage show productions; screen stage show programs; screen stage show performances; screen stage show documentaries; screen stage show acts; screen stage show plays; screen stage show sitcoms; screen stage show shows; screen stage show games and screen stage show realities wherefrom hereto concretizing efficiencies and effectiveness for the benefit members of the aforementioned UNIVERSAL POPULACE™ anywhere, anytime and anyplace within every and all of the national sovereign borders of every and all of the industrialized, developed and developing free-market commerce and trade bloc economies of a single holistically econometric marketplace environment. Whereas, TRACKSHOW™ is intended to cohesively in real-time mode naturally and seamlessly integate every and all, without limitation, member senior executives, board directors, audit committee members, internal auditors, independent auditors, shareholder's of record, securities analysts, creditors and members of the aforementioned UNIVERSAL POPULACE™. Whereas, TRACKSHOW™ is a universal market forum intended to increase association members of the aforementioned UNIVERSAL POPULACE™ in their respective fields with industry leadership, market presence and strategic positioning. Whereas, this natural and seamless forum premised on an integrated digital environment assists in protecting the value of members of the aforementioned UNIVERSAL POPULACE™ while ensuring their strategic goals and long-term objectives are never compromised. Whereas, TRACKSHOW™ is customizable to every and all subscribing individual members of the aforementioned UNIVERSAL POPULACE™ given certain parameters of standardization, and is envisioned to become the promulgating venue of preference for individual members of the aforementioned UNIVERSAL POPULACE™. reports and performance figures of individual members of the aforementioned UNIVERSAL POPULACE™. Whereas, TRACKSHOW™ software application information is further to include, without limitation, mergers and acquisitions, joint ventures, economic and political developments, transnational volatility and/or important wide-spread econometric accounting, communicating, transporting, energizing, reconciling, fueling, broadcasting, distributing and financing. TRACKSHOW™ enables transfiguration of every and all aforementioned fragmenting capital market inefficiencies into a natural and seamless integrally efficient, effective, functional and integrated method of disseminating transnational data and/or information to every and all individual members of the aforementioned UNIVERSAL POPULACE™ in customized fashion with steadfast adherence to identic syntactic UNIVERSAL CAPITAL MARKET™ pragmatic sanction standardization parameters. Whereas, TRACKSHOW™ disseminates information regarding corporate developments, trading volume, matching, clearing, executing, settling and exchanging activity on aforementioned PUBLIC FINANCIALS™ instruments inclusive of, naturally and seamlessly combined, interlocked, interchained, interleaved, intertwined, coiled and empowering aforementioned PUBLIC FINANCIALS™ statements from every and all members of the aforementioned PUBLICT FINANCIALS™ organizations whom are also clearly, undeniably, logically, scientifically and intutively members of the aforementioned UNIVERSAL POPULACE™. Whereas, TRACKSHOWT software application also disseminates real-time data and/or information on hretofore so-called press releases which include, without limitation, large-scale changes in participating member ownership and/or participating member operational, management and/or administrative control, strategic partnerships, strategic alliances, worldwide trends, economic market news, and other aspects of a single holistically econometric marketplace environment of technology, business, law, finance, accounting and auditing. Whereas, software application integrates worldwide financial newswire digital-streaming as extremely valuable to individual members of the aforementioned UNIVERSAL POPULACE™ as a complement to dissemination of real-time financial statements and non-financial public information. Whereas, TRACKSHOW™ offers specific market coverage of the real-time daytime and/or months, trimesters, and years. TRACKSHOW™ keeps members of the aforementioned UTNIVERSAL POPULACE™ abreast of a comprehensively suitable, generally pertinent and broadly useful data and/or information playing and/or replaying, notifying and/or renotifying related to every and all forms of transactional exchange initiatives, schemes, ocurrences, happenings, interactions, processes, methods, practices, movements, proceedings, messaging, presentations, notifications, filings, submissions, records, activities, actions, events, endeavors, tasks and affairs; Whereas, TRACKSHOW™ offers real-time coverage on equities, heretofore debt, industries, development trends, regulatory changes, corporate filings, weather forecasts, currencies accumulations/devaluations, contract activity, trading volumes, futures contracting, including every and all governmental and econometric related data and/or information on topics, issues, matters, items or concerns.

Whereas, TRACKTRADE™, wherefrom collectively innate conception, terminological conveyance, indivisible rubric, syntactic oralformulaic, unique artwork, systematic arrangement, differentiated crafting, artistic construct, melodious lyrics, denominative literateness and thereat proprietary multiport revolving chambered binary hunting metallic track encasing hermetic lock up cast casing constrained unified real-time microprocessor machine language object block keyhole combinational software computer code heretofore and hereafter apprehends TRACKTRADE™, heretofore formally utilized proprietary trademark and/or service mark exclusively owned intellectual property of Juan Carlos Castro, is a software application which offers retail and/or institutional, members of the aforementioned UNIVERSAL POPULACE™ with 24-hours a day, 7-days a week access to our proprietary securities quotation and exchange validation system. Whereas, this software application offers members of the aforementioned UNIVERSAL POPULACE™ access to a real-time securities exchange platform. This software application is a multifaceted software application whose structural foundation lies in its ability to seamlessly account for securities transactional processing in real-time mode to a complete sum in an efficient and effective manner. Whereas, TRACKTRADE™ is a software application which systematically offers best platform for every and all aforementioned PUBLIC FINANCIALS instruments, wherefrom anonymously and in real-time enabling matching, clearing, executing, settling and exchanging premised on effectuating well-informed, objective, risk-managed and self-assured trading decisions via licensed utilization of aforementioned UCMOST™ information technologies.

Whereas, TRACKVIEW™, wherefrom collectively innate conception, terminological conveyance, indivisible rubric, syntactic oralformulaic, unique artwork, systematic arrangement, differentiated crafting, artistic construct, melodious lyrics, denominative literateness and thereat proprietary multiport revolving chambered binary hunting metallic track encasing hermetic lock up cast casing constrained unified real-time microprocessor machine language object block keyhole combinational software computer code heretofore and hereafter apprehends TRACKVIEW™, heretofore formally utilized proprietary trademark and/or service mark exclusively owned intellectual property of Juan Carlos Castro, is an software application which offers continuous access to real-time divisional and consolidated accouting statements reporting information related to member subsidiary aforementioned PUBLIC FINANCIALS™ organizations with 24-hours a day, 7-days a week continuous access to this mission critical data and/or information which includes without limitation, the segment, divisional and/or consolidated income statement, balance sheet, cash flow statement, and statement of changes in participating members equity. Whereas, TRACKVIEW™ offers individual members of the aforementioned UNIVERSAL POPULACE™ vital access to information that is necessary for them to fully understand the treasure accounting, financial fueling and econometric energizing of the organization in whom they prefer to deposit their hard earned points, wherefrom these forms of data and/or information are to include, without limitation, the management discussion and analysis describing the current state of affairs, financial projections and long-term strategic plans for the integrated entity. Whereas, TRACKVIEW™ ensures that members of the aforementioned UNIVERSAL POPULACE™ are offered real-time visual display of the financial statements and non-financial public information of each singular operating segment that is under the direct real-time processes which facilitates real-time assets, liabilities, equities, profits and losses, and related data and/or information from members, divisions, departments, units and sub-units of a public sector organization whether operated in disparet and/or centralized form and transcendin a world-wide marketplace whose aim, letter, nature, spirit, scope, breadth and depth are the premise of the aforementioned efficient UNIVERSAL CAPITAL MARKET™. Whereas, TRACKVIEW™ ensures real-time divisional and consolidated data and/or information from a public organization are continuously tramisting to members of the aforementioned members of the UNIVERSAL POPULACE™ simultaneously and in real-time mode without intermediary assistance from anyone, anytime, anyplace and/or anywhere within, throughout and transcending the aforementioned efficient UNIVERSAL CAPITAL MARKET™. Whereas, TRACKVIEW™ realizes the utility provisions of an advanced software application that serves to protect the treasure accounting, financial fueling and econometric energizing members of the aforementioned UNIVERSAL POPULACE™ from around the world. Whereas, TRACKVIEW™ secures free-market controls and real-time accountabilities in public sector accounting, transporint, reporting and/or auditing from members of the aforementioned UNIVERSAL POPULACE™ which clearly, undeniably, logically, scientifically and intuitively transcend each and every one of the industries and sectors of all sovereign nations from around the world. Whereas, TRACKVIEW™ is a facilitating software application that establishes a new and higher standard of full disclosure within an efficient UNIVERSAL CAPITAL MARKET™. Whereas, TRACKVIEW™ enables public corporations, government entities and not-for-profit organizations to comply with a new real-time public sector accounting and financial reporting standard in active and passive automation to offer individual members of the aforementioned UNIVERSAL POPULACE™ accessing aforementioned UCMOST™ real-time processing and/or reprocessing partible iota particle beta trace element isomorphic transmuting transmission capabilities which serves as a consummate pretaxis cutting-edge utitliy and original constructive reduction to practice which assists to effectuate well-informed, objective and self-assured financial and transactional exchange decisions. Whereas, TRACKVIEW™ offers a virtually specific world of information in an environment that hosts financial accounting, financial fueling and econometric energizing. Whereas, TRACKVIEW™ is a innovative software application which offers members of the aforementioned UNIVERSAL POPULACE™ an opportunity to comply with a new and higher standard of public accounting, financial reporting and independent and gain access to a richly powerful risk-management computing platform of econometric trend monitoring services whereby TRACKVIEW™ assists members of the aforementioned UNIVERSAL POPULACE™ to effectuate well-informed, objective and self-assured transactional exchange and financial decisions by offering presentation of customizable visual graphics and a multitude of standard analytical ratios. Whereas, TRACKVIEW™ assists in analyzing the cumulative changes and financial trends, between the closing of an accounting period or cycle and the submission of statutorily required filings to the so-called U.S. SEC. For example, let's assume that a member of the members of the aforementioned UNIVERSAL POPULACE™ is interested in effectuating a transactional exchange decision on 1/1/00 using the 12/31/99 10-K aforementioned PUBLIC FINANCIALS™ statements of a member of the aforementioned PUBLIC FINANCIALS™ organizations, assuming a calendar year accounting cycle. The reality of the reporting environment of the capital market heretofore is that members of the aforementioned UNIVERSAL POPULACE™ are via inopportune fashion forced to wait until 4/1/00 to receive the 12/31/99 10-K aforementioned PUBLIC FINANCIALS™ instruments. Whereas, TRACKVIEW™ software application bridges the heretofore obfuscating, obscurant, antiquated, ancient history and superannuated so-called disciplinary fields involving traditionally separate and distinctively exclusive specialty areas of accounting, communicating, transporting, energizing, fueling, broadcasting, distributing and financing to concretize hereafter a natural and seamless wrapping, interlacing, coiling, coupling, combining and interlocking interdisciplinary field of art, thus eradicating every and all heretofore aforementioned fragmenting capital market inefficiencies which preclude, prevent, enthrall, pretense, harass, press, engulf, presume and oppress innovative developments and technological advancements within, throughout and transcending real-time processing inclusive of real-time reprocessing of data and/or information receiver by seamlessly interfacing within TRACKVIEW™ offers timely, statements. Whereas, TRACKVIEW™ offers real-time public econometric consolidated reporting as is possible under the heretofore constraints of multiple accounting systems, operating systems, lack of internal financial reporting standards, integrated bookkeeping, industry standardized processes and accounting interpretations of typical industry transactions. Whereas, TRACKVIEW™, enables necessary trace entries posted to ledger account balance can take the form of economic transactions, occurrences, events, items, and cost or expense driven activities from related divisions, departments, units and subunits of amembers of the aforementioned UNIVERSAL POPULACE™. Whereas, TRACKVIEW™ enables real-time visualization of account balance revisions, adjustments, reclassifications and restatements to the cumulative changes in account ledger balances, and the divisional and consolidated financial statements. Furthermore, TRACKVIEW™ software application is envisioned to be the universal benchmark for tracking real-time financial statements, business risks, cumulative accounting activity to enable real-time analysis of the transactional exchange, financial, and operating performance results related to members of the aforementioned PUBLIC FINANCIALS™ organizations and/or, when applicable, under statutory guidelines and/or pragmatic sanction every and all members of the aforementioned UNIVERSAL POPULACE™. Whereas, TRACKVIEW™ is a richly functional software application ensures real-time auditing functionality via the following methodology which ensures real-time reconciling of every and all below mentioned data link caster dart pellet casting interfacing pulsatory signaling transmission line interactivity between and among the multifaceted octogonal multitrack UCMOST operating system; whereas, TRACKVIEW™ is characterized as a novel and unique cutting-edge and conceptually simplified methodology eliciting an unobvious technological advancement eliciting an unknown, unforeseen and unprecedented matrix reconciling process which inherently elicits a two-dimensional data link dart trace element identification in the form of display of every and all data and/or information transported from/to every and all inter-related sub-units, units, department, divisions and/or multifaceted industry segment operations involving members of the aforementioned PUBLIC FINANCIALS™ organizations and/or transported from/to every and all members of the aforementioned UNIVERSAL POPULACE™ . Whereas, witin a spreadsheet a matrix-oriented reciprocal account which enables real-time matching and identifying procedural requisites which elicit a real-time matching, clearing, executing, settling and exchanging utility functionality incorporating every and all inter-related sub-units, units, department, divisions and/or multifaceted industry segment operations involving members of the aforementioned PUBLIC FINANCIALS™ organizations and/or transported from/to every and all members of the aforementioned UNIVERSAL POPULACE™; whereas, identifies, authenticates, and graphically displays inter-related transfer journal entries from single/multiple sub-units, units, departments, and divisions. Moreover, TRACKVIEW™ is characterized by a capacity to easily and swiftly track real-time transporting of data and/or information while seamlessly managing via standardizing procedures and parameters which enabling the real-time reconciling of every and all heretofore so-called journal entries to the sum of zero whereby eliminating every and all discrepancies which occur and heretofore for ages and ages have fecklessly, irresponsibly, irrationally and deliberately remained undisclosed, veiled and/or fraudulently so-calld buried within the heretofore so-called statement of financial position and/or so-called balance sheet of inter-related sub-units, units, department, divisions and/or multifaceted industry segment operations involving members of the aforementioned PUBLIC FINANCLILS™ organizations. Whereas, TRACKVIEW™ is characterized by a capacity to instantaneously identity every and all ledger balance mismatches and/or heretofore so-calld journal entries with inadequate and/or insufficient digital-originating and/or manually scanned in supporting documentation evincing a real-time notification and/or message process evincing a novel capacity to reroute and/or redirect every and all so-called mismatched and therefore flagged data link dart pelleting casting journal entries as requisite correctional entries which requisite instantaneous and/or follow-up review and/or documented which precludes any and all capacity to heretofore so-called book and/or post any such unreconciling entries within the master general ledger of the aforementioned PUBLIC FINANCIALS™ organizations. Whereas, within the novelty of the matrix reconciling characteristic functionality heretofore and hereafter part and form of the uniqueness of this application software processing program, every and all real-time entries must not these so-called entries are evinced from so-called non-related operating segments of an aforementioned PUBLIC FINANCIALS™ organizations whose so-called ledger account balances heretofore reside in distinctive accounting so-called books located in distincitively separate geographical locations. Whereas, TRACKVIEW™ is characterized by a real-time capacity and/or real-time capabilities to monitor composite and/or hybrid separation of every and all so-called accounting transports of data and/or information from any one originating inter-related sub-units, units, department, divisions and/or multifaceted industry segment operations offering a real-time decision-analysis support system enabling real-time functionality which elicits automatizing necessary prefixed and real-time supporting reconciling adjustments to recurring erratic inter-related accounts found prevelant whereupon requiting every and all remedial managing, administrative and operating procedures to eradicate any such mismatching so-called entries which involve aforementioned UCMOST™ real-time processing and/or reprocessing from prolonged persistence whereby otherwise flagging the aforementioned PUBLIC FINANCIALS organization for immediate automatizing and manual regulatory compliance review and potential civil injunctions and/or ceast-and-desist and sequestration via rubricating identic pragmatic sanction order. Whereas, TRACKVIEW™ is a uniquely novel concept of matrix reconciliation premised on the requisite necessity within an clearly, undeniably, logically, scientifically and intuitively evinced information economy to ensure, requsite and sustain high-quality, prudence, integrity, honor, respect, honesty, accuracy, reliability, verifiability, transparency, relevance, comprehensiveness and understandability in every and all public accounting, transporting reconciling, independent auditing and financial reporting. Whereas, TRACKVIEW™ elicits a characteristic single heliocentrical marketplace environment which clearly, undeniably, logically, scientifically and intuitively is exclusively created with utilization of this novel technological advancement which intrinsically and inherently elicits perfect accountability of every and all forms of public accounting, transporting reconciling, independent auditing and financial reporting and without a doubt elicits a novel capacity and/or capability to visually trace, identify, analyze and account for every and all so-called heretofore irrelevant factors involving bookkeeping basis via so-called writing off practices and/or those which are likely hidden or buried in the statements of financial position; wherefrom it is a clear, undeniable, logical, scientific and intutive findings that within matrix reconciliation mismatches are not allowed to be so-called booked and/or so-called manual posted, which hereto requisite aforementioned UCMOST™ real-time processing and/or reprocessing and supplant every and all hereinbefore mentioned so-called booking and/or so-called manual posting; whereas, any such mismatches which are evinced are automatically flagged by the internal logic operator functionality of UCMOST™ wherefrom efficiently rerouting every and all so-called mismatches to the correctional bin for subsequent quality review by the UCMOST™ internalized information technological processes, methods and/or procedures. Whereas, the novel premise of matrix reconciling is to ensure a single heliocentrical econometric marketplace environment is provided which a novel process and/or methodology which enables a structural foundation necessary to seamlessly requisite perfectly positively correlated reconciliation of every and all econometric interactivity to a numeric number of zero and/or numer number of one, given an insignificant decimal-based adjustment for slight variance in numeric system rounding differences. Whereas, heretofore the antiquated, archaic, ancient history and superannuated concepts, standards, practices and guidelines of the so-called professional practice of public accounting, transporting, financial reporting and independent accounting have negligently enabled immersurable and enormous amounts of so-called monies to be unaccounted for and consistently misclassified and/or deemed not relevant enough to publicly disclose as unreconciled transfer of so-called currency from/to originating and/or receiving inter-related sub-units, units, department, divisions and/or multifaceted industry segment operations under the antiquated, obscurant, insolent, arrogant, archaic, superannuated, unacceptable and intolerable heretofore practices systematically carried out within, throughout and transcending the so-called distinctively separate and traditionally exclusive so-called specialty areas of public accounting, transporting reconciliation, independnent auditing and financial reporting under the feculent, feckless, irresponsible and irrational preconceived notions of materiality issues, topics, matters, discourse, controvery and/or discussions; whereas, hereafter every and application which offers members of the aforementioned UNIVERSAL POPULACE™ matrix-oriented inter-member ledger account balance reconciliation 24-hours a day, 7-days a week. Whereas, TRACKVIEW™ offers continuous access to inter-member ledger balances and easily identifies chart trace entries which do not reconcile during periods interim of statutorily required financial statements to the so-called U.S. SEC. Moreover, TRACKVIEW™ is a software application that enables senior executives to book missing and/or lagging entries, and make likely adjustments, revisions, restatements and reclassifications in a timely, efficient and effective manner. Whereas, TRACKVIEW™ software application offers senior executives relevant financial and non-financial public information necessary to make an efficient and effective decision, to continuously enable real-time transportinga nd reconciling of inter-member ledger account balances. Furthermore, TRACKVIEW™ as a novel software application is considered an ease of use and simplified, novel methodological and real-time procedural approach to the reconciliation requisite, and inherently elicits a two-dimensional, trace verification of inter-member trace entries via color-coded visual graphic oriented braodcast display of accounting data transportred to/from subsidiaries and/or the parent chart of accounts. Whereas, TRACKVIEW™ reconciling processes is predicated on aforementioned UCMOST™ real-time processing and/or reprocessing of every and all, without limitation, inter-member ledger balance so-called trace debits and credits whereby enabling such real-time activities to be identified, authenticated, traced and graphically displayed in real-time mode. Whereas, TRACKVIEW™ is a software application is capable of handling tens of hundreds of billions of dart trace entries from every and all members of the aforementioned UNIVERSAL POPULACE inclusive of, without limitation, every and all prefixed legally operated work productivity segments, subsidiaries, divisions, battalions, departments, units and/or sub-units to facilitate real-time data and/or information transporting, in whole and in part, whence logically the utmost reliance metric check existent in the universe. Whereas, TRACKVIEW™ software application enables senior executives to monitor hybrid separation of accounting data from a disseminating member to one and/or multiple receiver members and effectuates automatizing adjustments to inter-member accounts on a continuous basis identified, analyzed, traced, accounted for, reclassified, restated or readjusted instantaneously within inter-member ledger account balances. Whereas, furthermore, TRACKVEW™ offers visual identification, in a timely, reliable and secure fashion, so that bookkeeping irregularities that come to exist, already exist, and those which may be buried in amembers of the aforementioned UNIVERSAL POPULACE™ balance sheet can be properly balanced in any situation with steadfast adherence to real-time accounting, transporting, reporting and auditing interpretations. Whereas, TRACKVIEW™ software application affords senior executives an efficient capability to take responsible action via semi-automated chart trace entries enabling efficient adjustment to inter-member ledger balance accounts or imbalances from a disseminating member to one and/or multiple receiver involving members within any one or more intermember ledger balances. Whereas, TRACKVIEW™ is a software application which facilitates accurate real-time financial statements data and/or informationy to maintain dedicated integration and unequivocal steadfast adherence to a new theater of operations and higher standard of excellence entailing, encompassing, comprising, involving, impact and effecting every and all heretofore preconceived fecklessly irrational notions of accuracy, quality, timeliness, reliability, transparency, verifiability, comprehensiveness and understandability whereby offering a comprehensively suitable, generally pertinent and broadly useful utility and design innovation which entirely standalone is fully technically capable of traversing within, throughout and transcending an identic rubric pragmatic sanction over every and all, without limitation, of the heretofore distinctively separate and traditionally exclusive speciality areas of accounting, communicating, transporting, energizing, fueling, broadcasting, distributing and/or financing econometric transacting.

Whereas hereto, the above comprehensive general background of the specificiation of my above patent inclusive of, without limitation, software programs incorporation as part and form of functionality of this specificiation is now more conceptually represented via abstract spatial geometric drawing(s) accompanying the above and below parts and forms of this specification which in combination with the below list of reference numerals

### BRIEF DESCRIPTION OF THE DRAWING(S)

The accompanying drawing(s) which constitute intrinsic parts and forms incorporated herein and of which every and all are comprehensively suitable, generally pertinent and broadly useful to offer features of proof hereto evincing consummate constructive reduction to practice delineated within the specification of my invention, inclusive of the above generally described and below detailed description list of reference numbers represent the preferred, additional and alternative embodiments within the drawing(s) given below, wherefrom every and all aforementioned assist cognizably in graphically illustrating conceptual exploded figurative sketch design(s) inclusive of imploded detailed flow chart sketch design(s) outlining holistic integration of the preferred embodiments, additional embodiments and alternative embodiments hereto concretizing multitudes of multifaceted and multidimensional principles, standards, combinations, processes, methodologies, elements, factors, components, constituents and ingredients of my invention.

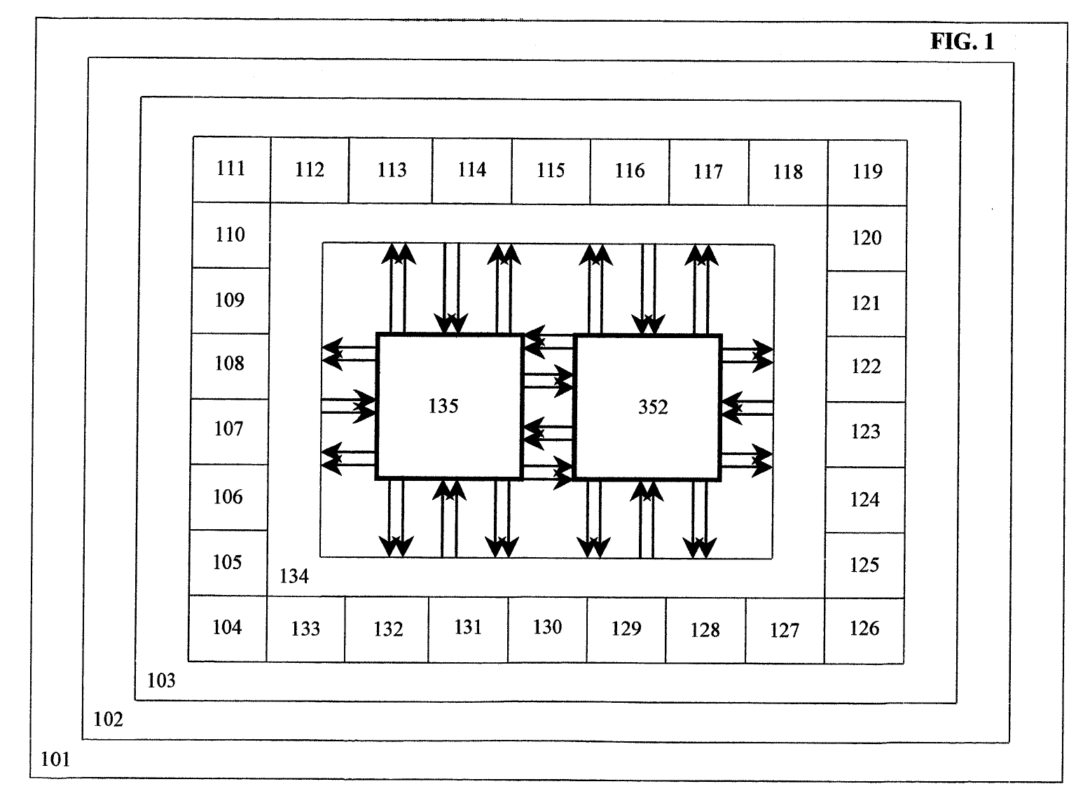

(a) FIG. 1 shows a imploded view comprising UCMOST™ central microprocessor unit;

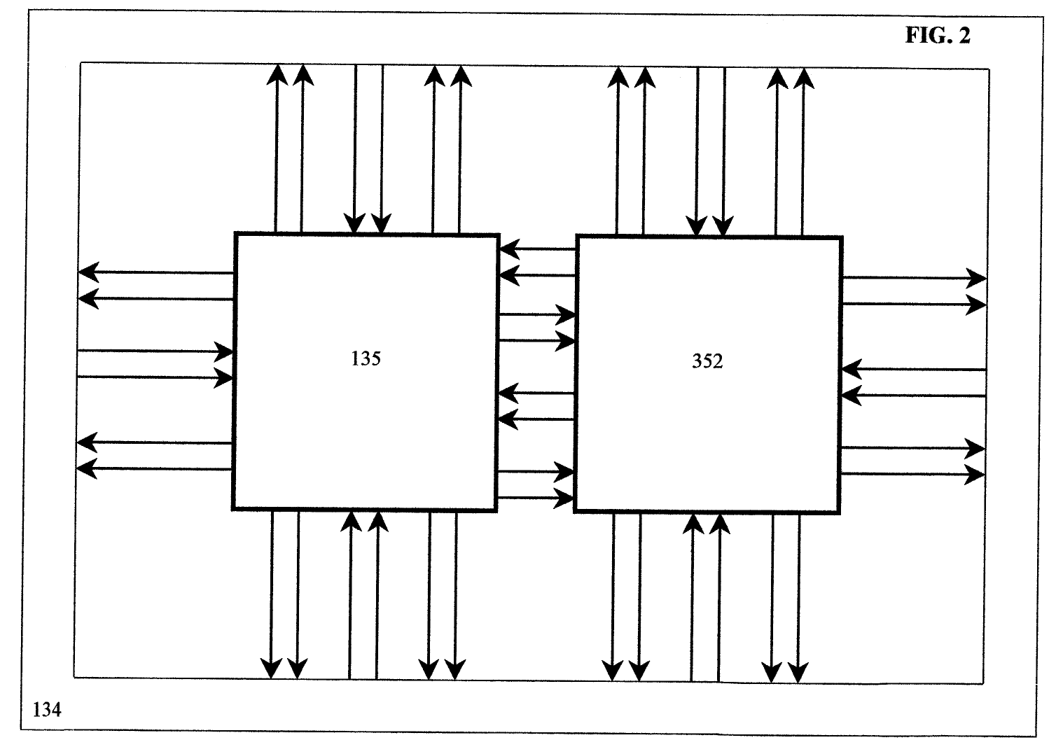

(b) FIG. 2 shows a partial exploded view comprising UCMOST™ central microprocessor unit;

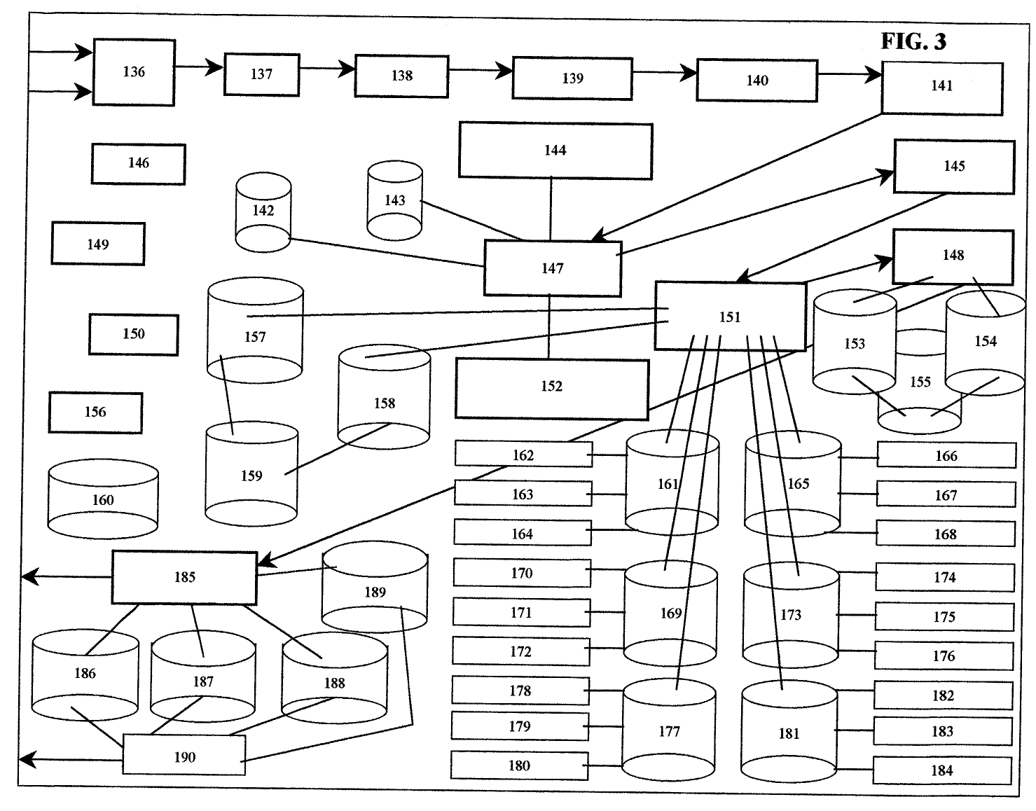

(c) FIG. 3 shows a exploded flow chart comprising UCMOST™ accounting information system;

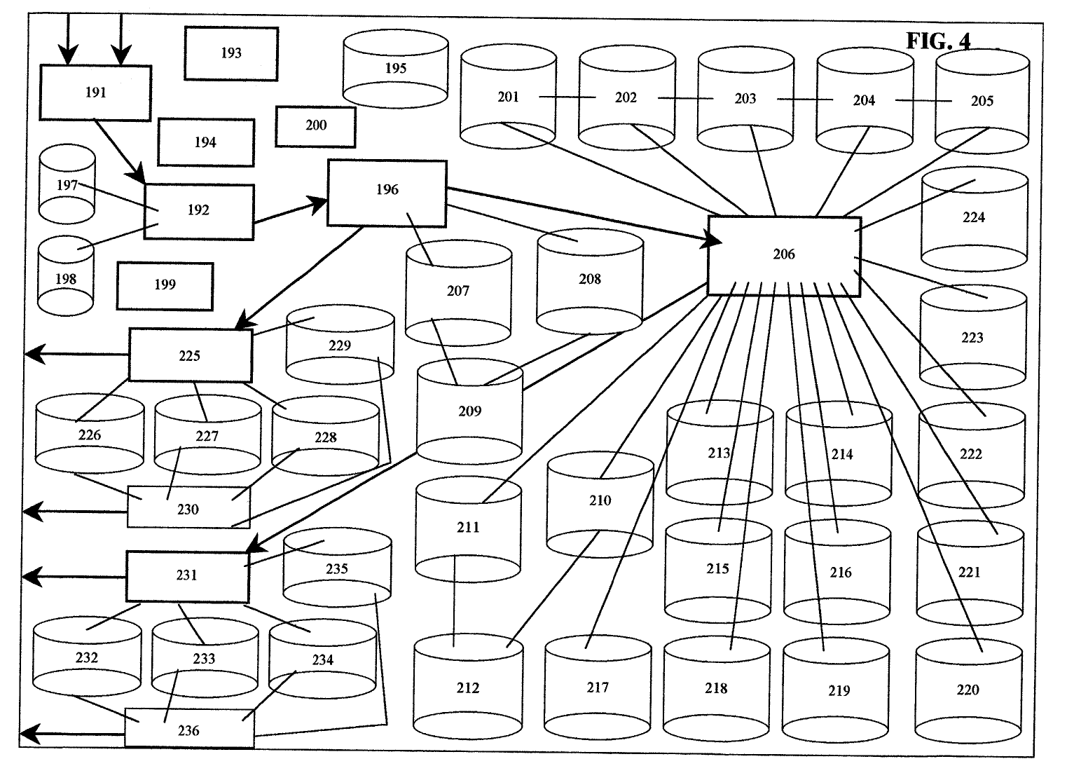

(d) FIG. 4 shows a exploded flow chart comprising UCMOST™ reconciling information system;

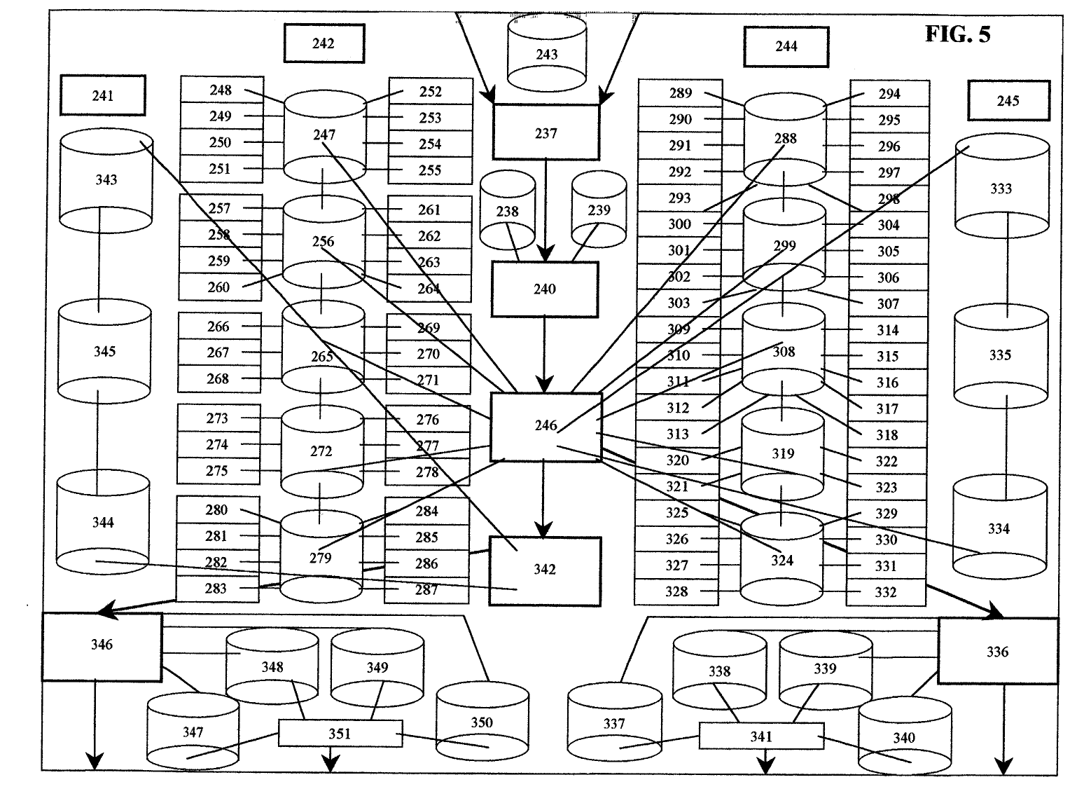

(e) FIG. 5 shows a exploded flow chart comprising UCMOST™ reporting information system;

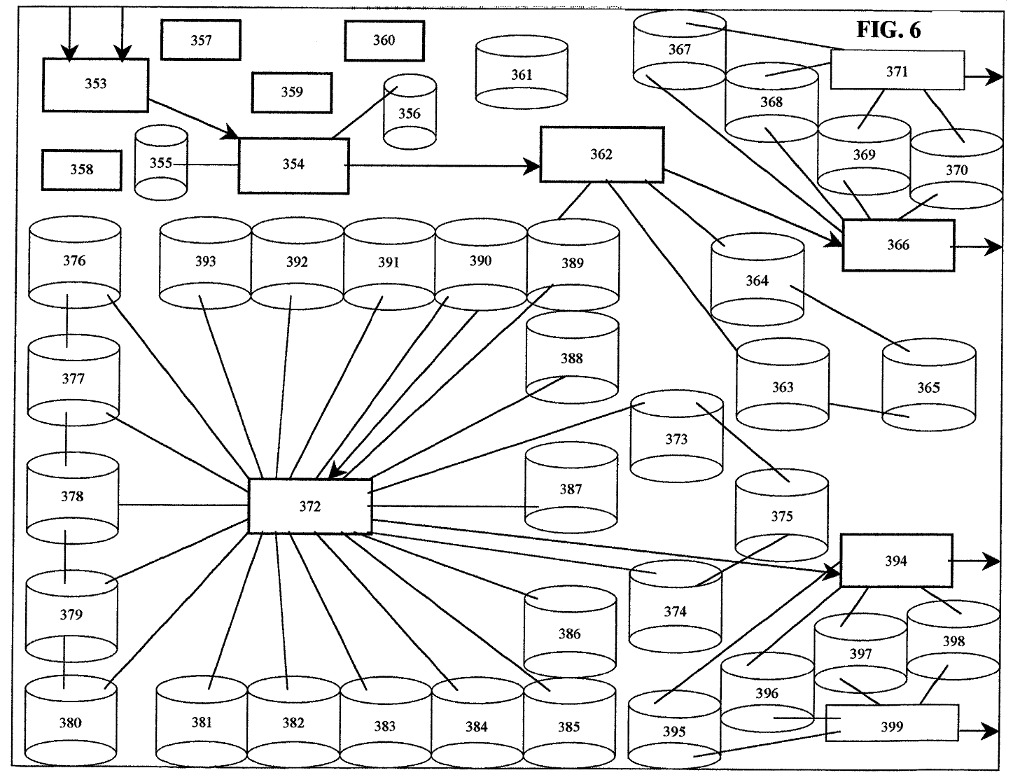

(f) FIG. 6 shows a exploded flow chart comprising UCMOST™ treasuring information system;

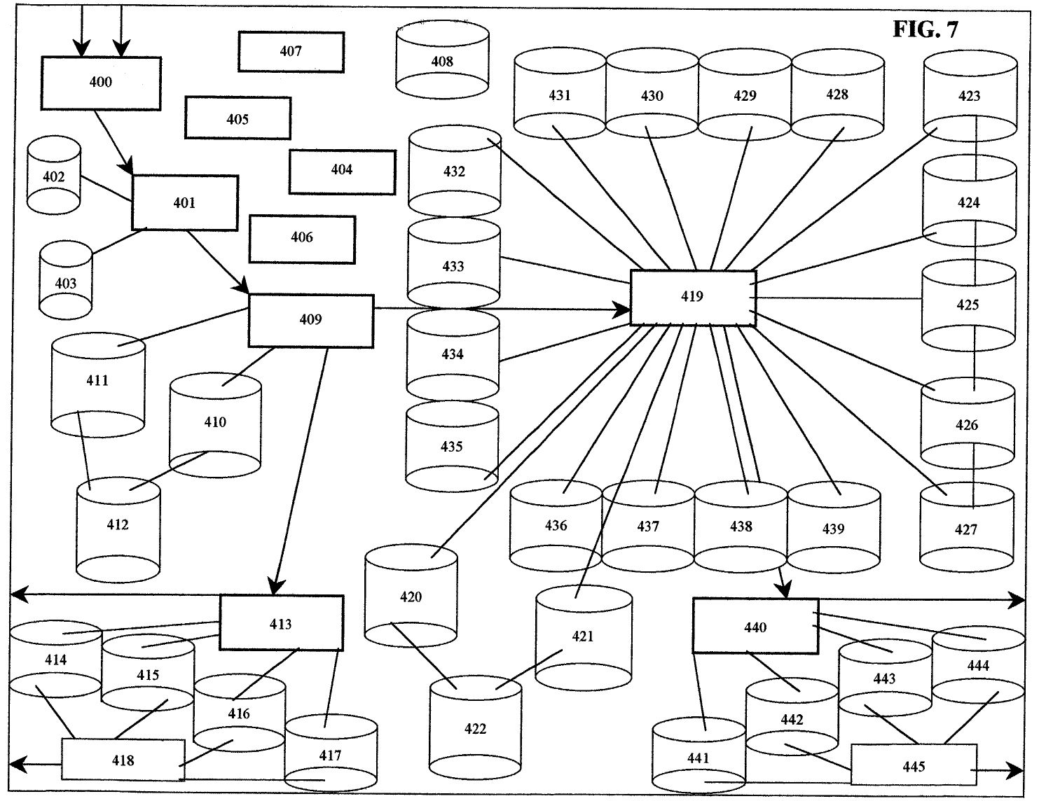

(g) FIG. 7 shows a exploded flow chart comprising UCMOST™ distributing information system;

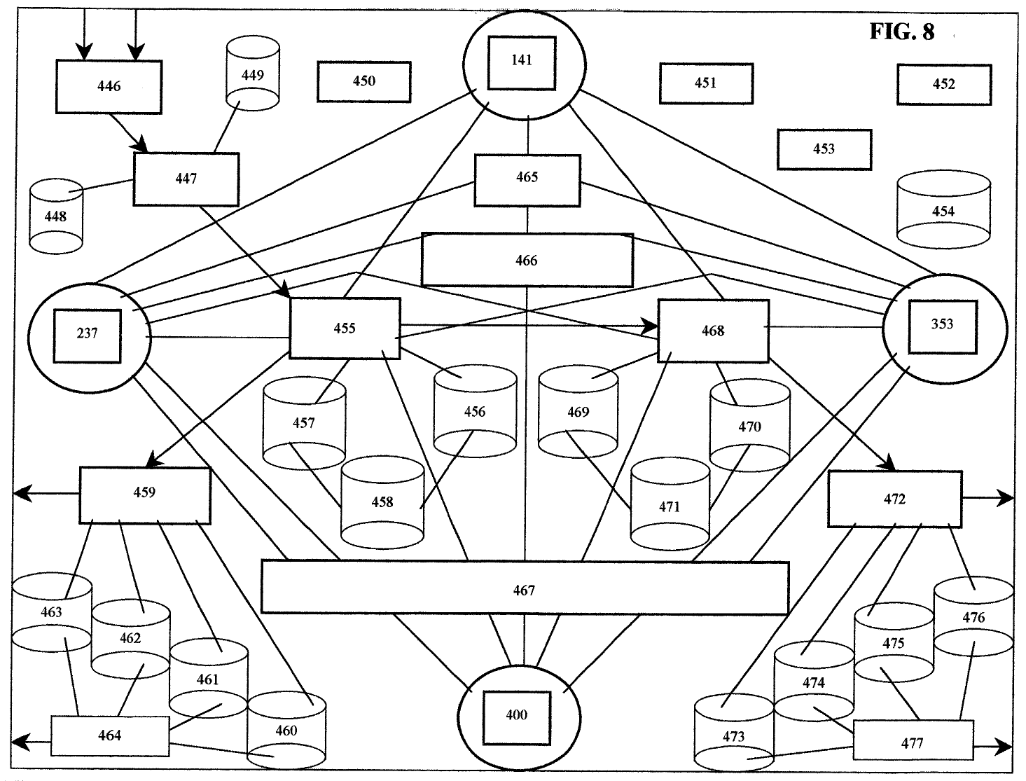

(h) FIG. 8 shows a exploded flow chart comprising UCMOST™ financing information system.

### LIST OF REFERENCE NUMERALS IN THE DRAWING(S)

101 security rhombic closed-circuit hardcore central microprocessor unit casting block

102 protective rhombic plane applications program software apostrophe interface station

103 encasing rhombic plane applications software programs casting keyway pod station

104 functional rhombic plane application software processing encased program station

105 functional rhombic plane application software processing encased program station

106 functional rhombic plane application software processing encased program station

107 functional rhombic plane application software processing encased program station

108 functional rhombic plane application software processing encased program station

109 functional rhombic plane application software processing encased program station

110 functional rhombic plane application software processing encased program station

111 functional rhombic plane application software processing encased program station

112 functional rhombic plane application software processing encased program station

113 functional rhombic plane application software processing encased program station

114 functional rhombic plane application software processing encased program station

115 functional rhombic plane application software processing encased program station

116 functional rhombic plane application software processing encased program station

117 functional rhombic plane application software processing encased program station

118 functional rhombic plane application software processing encased program station

119 functional rhombic plane application software processing encased program station

120 functional rhombic plane application software processing encased program station

121 functional rhombic plane application software processing encased program station

122 functional rhombic plane application software processing encased program station

123 functional rhombic plane application software processing encased program station

124 functional rhombic plane application software processing encased program station

125 functional rhombic plane application software processing encased program station

126 functional rhombic plane application software processing encased program station

127 functional rhombic plane application software processing encased program station

128 functional rhombic plane application software processing encased program station

129 functional rhombic plane application software processing encased program station

130 functional rhombic plane application software processing encased program station

131 functional rhombic plane application software processing encased program station

132 functional rhombic plane application software processing encased program station

133 functional rhombic plane application software processing encased program station

134 security plane application hardcore operating system encasing block pod station

135 functional plane sub-compartment parallel central microprocessor sub-unit

136 orthorhombic plane automatizing real-time data and/or info. accounting input receiver

137 orthorhombic plane automatizing real-time data and/or info. accounting input receiver

138 orthorhombic plane automatizing real-time data and/or info. accounting input receiver

139 orthorhombic plane automatizing real-time data and/or info. accounting input receiver

140 orthorhombic plane automatizing real-time data and/or info. accounting input receiver

141 orthorhombic plane consolidating real-time data and/or info. accounting input receiver

142 helix bay of automatizing real-time data and/or info. accounting kick out and/or undo

143 helix bay of automatizing real-time data and/or info. accounting input spool

144 rhombic plane real-time divisional data and/or info. accounting trace chart of accounts

145 plane automatizing real-time data and/or info. accounting open-order match book

146 rhombic plane automatizing real-time data and/or info. high-quality review station

147 rhombic plane real-time data and/or info. accounting order metric conversion station

148 orthorhombic plane automatizing real-time master general ledger booking station

149 plane automatizing real-time data and/or info. accounting system control station

150 plane real-time data and/or info.accounting digital custom feeds control station

151 plane automatizing real-time data and/or info.accounting ledger validation station

152 plane real-time data and/or info. consolidated accounting trace chart of accounts

153 helix bay of real-time data and/or info.accounting master ledger history file storage

154 helix bay of real-time data and/or info.accounting master ledger data file storage

155 helix bay of real-time data and/or info.accounting master ledger statistics storage

156 plane real-time data and/or info. accounting spatiotemporal tracking meter station

157 helix of real-time data and/or info.accounting ledger spatiotemporal history file storage

158 helix bay of real-time data and/or info.accounting ledger spatiotemporal data file storage

159 helix bay of real-time data and/or info.accounting ledger account statistics storage

160 helix bay of real-time data and/or info.accounting ledger spatiotemporal correction log

161 helix bay of real-time data and/or info.general accounting standards database cabinet

162 plane automatizing data and/or info.general accounting principles database drawer

163 plane automatizing data and/or info.general accounting concepts database drawer

164 plane automatizing data and/or info.general accounting standards database drawer

165 helix real-time data and/or info.accounting transnational standards database cabinet

166 orthorhombic plane automating transnational accounting principles database drawer

167 orthorhombic plane automatizing transnational accounting standards database drawer

168 orthorhombic plane automatizing transnational interpretation s database drawer

169 helix real-time accounting trace ledger balance reporting standards database cabinet

170 orthorhombic plane automatizing standard reporting points bulletins database drawer

171 orthorhombic plane automatizing standard reporting releases database drawer

172 orthorhombic plane automatizing standard reporting interpretations database drawer

173 helix real-time accounting trace transnational reporting standards database cabinet

174 orthorhombic plane automatizing transnational accounting releases database drawer

175 orthorhombic plane automatizing transnational accounting statements database drawer

176 orthorhombic plane automatizing transnational interpretations database drawer

177 helix bay of real-time accounting trace governmental standards database cabinet

178 orthorhombic plane automatizing governmental principles database drawer

179 orthorhombic plane automatizing governmental standards database drawer

180 orthorhombic plane automatizing governmental interpretations database drawer

181 helix real-time accounting trace transnational auditing standards database cabinet

182 rhombic plane automatizing transnational standards database drawer

183 rhombic plane automatizing transnational interpretations database drawer

184 rhombic plane automatizing general transnational practices database drawer

185 rhombic plane real-time data and/or information accounting transmission output

186 helix bay of real-time data accounting transmission history file storage

187 helix bay of real-time information accounting transmission history file storage

188 helix bay of data, info. charactery, numeric, voice, video and image transmission storage

189 helix real-time data, info., charactery, numeric, voice, video and image transmission log

190 plane data, info., charactery, numeric, voice, video and image transmission recovery

191 orthorhombic plane automatizing real-time data and/or info. reconciling input receiver

192 plane automatizing real-time data and/or info. reconciling order metric conversion station

193 plane automatizing real-time data and/or info. reconciling high-quality review station

194 plane automatizing real-time data and/or info. reconciling system control station

195 helix bay of automatizing real-time data and/or info. reconciling correction log

196 plane real-time automatizing open-order data and/or info. reconciling match book

197 helix automatizing data and/or information reconciling kick out and/or undo folder

198 helix bay of automatizing real-time reconciling system automatizing input spool

199 plane real-time data and/or info. spatiotemporal reconciling tracking meter station

200 rhombic plane real-time data and/or information reconciling custom control station

201 helix bay of real-time data and/or information reconciling system matching station

202 helix bay of real-time data and/or information reconciling system clearing station

203 helix bay of real-time data and/or information reconciling system executing station

204 helix bay of real-time data and/or information reconciling system settling station

205 helix bay of real-time data and/or information reconciling system exchanging station

206 rhombic plane automatizing real-time data and/or info. reconciling validation station

207 helix bay of real-time open-order data and/or info. reconciling history file storage

208 helix bay of real-time open-order data and/or info. reconciling file storage

209 helix bay of real-time open-order data and/or info. reconciling statistics storage

210 helix bay of real-time validation data and/or info. reconciling history file storage

211 helix bay of real-time validation data and/or info. reconciling file storage

212 helix bay of real-time validation data and/or info. reconciling statistics storage

213 helix bay of treasures, retained earnings, equity and participation interests

214 helix bay of treasuring cash equivalents, receivables, allowances and deferrals

215 helix bay of heretofore lifo and/or fifo, master inventory and master pricing lists

216 helix bay of property, casualty, life, health, disability, vision and dental contracts/policies

217 helix bay of extraordinary items, goodwill, deferred taxes, discontinued segments

218 helix bay of variable derivatives, treasure payable and long-term treasure obligations

219 helix bay of property, plant and equipment, depreciation/amortization plans/schedules

220 helix bay of cost of goods sold and real-time cost allocation plans and schedules

221 helix bay of operating labor expense and real-time cost allocations plans and schedules

222 helix of revenues net general administration, operating leases, research and development

223 bay of payroll taxes and work compensation assures, pension and deferred plan oblig.

224 helix bay of ledger accounts payable, treasure financings, discounts and accruals

225 rhombic plane real-time open-order data and information reconciling transmission output

226 helix bay of real-time open-order data reconciling transmission history file storage

227 helix bay real-time open-order information reconciling transmission history file storage

228 helix open-order charactery, numeric, audio, voice, video and image transmission storage

229 helix bay data, info., charactery, numeric, audio, voice, video and image transmission log

230 plane data, info., character, numeric, audio, voice, video and image transmission recovery

231 rhombic plane real-time validated data and information reconciling transmission output

232 helix bay real-time validated data reconciling transmission file storage

233 helix bay real-time validated information reconciling transmission history file storage

234 helix bay validated character, numeric audio, voice, video and image transmission storage

235 helix bay data, info., character, numeric, audio, voice, video and image transmission log

236 plane data, info., character, numeric, audio, voice, video and image transmission recovery

237 rhombic plane automatizing real-time reporting data and/or info. input receiver

238 helix bay automatizing data and/or information reporting kick out/undo folder

239 helix bay real-time data and/or information reporting automatizing input spool reel

240 rhombic plane automatizing data and/or info. reporting order metric conversion station

241 rhombic plane automatizing data and/or information reporting high-quality review station

242 rhombic plane automatizing data and/or information reporting system control station

243 rhombic helix automatizing real-time data and/or information reporting correction log

244 rhombic plane real-time data and/or info. spatiotemporal reporting tracking meter station

245 rhombic plane real-time data and/or information reporting custom control station

246 orthorhombic plane real-time automatizing data reporting open-order match book

247 helix bay real-time reporting methods, guides and standards database cabinet

248 orthorhombic plane automatizing real-time principles of financing database drawer

249 orthorhombic plane automatizing real-time valuation of currency database drawer

250 orthorhombic plane automatizing real-time equity instrument valuation database drawer

251 orthorhombic plane automatizing real-time instrument management database drawer

252 rhombic plane automatizing real-time stds., princ., ethics, obj. and cond. database drawer

253 rhombic plane automatizing real-time econometric cost-ben. analysis database drawer

254 rhombic plane automatizing real-time treasure obligation valuation database drawer

255 rhombic plane automatizing real-time quantitative methodologies database drawer

256 helix bay of real-time accounting, transporting, reporting and auditing database cabinet

257 orthorhombic plane automatizing real-time derivative options contracts database drawer

258 rhombic plane real-time accounting, transporting, reporting and auditing database drawer

259 plane automatizing real-time domestic and transnational tax account database drawer

260 orthorhombic plane automatizing real-time management accounting database drawer

261 rhombic plane automatizing real-time ind. accounting special reports database drawer

262 rhombic plane automatizing real-time activity-based cost accounting database drawer

263 rhombic plane automatizing real-time entitlement benefits accounting database drawer

264 rhombic plane automatizing real-time data and/or info. sys. accounting database drawer

265 bay of real-time gov. and/or org. accounting, transporting, reporting and auditing cabinet

266 rhombic plane automatizing real-time audit stds. and controls database drawer

267 rhombic plane automatizing real-time capital resource budget alloc. database drawer

268 rhombic plane automatizing real-time performance measurement database drawer

269 rhombic plane automatizing real-time stds., princ., ethics, obj. and cond. database drawer

270 plane automatizing real-time accounting, transporting, reporting and auditing drawer

271 rhombic plane automatizing real-time activity-based cost accounting database drawer

272 bay nfp, sch., univ., hosp., accounting, transporting reporting, auditing database cabinet

273 rhombic plane automatizing real-time internal treasure service funds database drawer

274 rhombic plane automatizing real-time organizational general funds database drawer

275 rhombic plane automatizing real-time treasure obligation service funds database drawer

276 rhombic plane automatizing real-time enterprise development database drawer

277 rhombic plane automatizing real-time organizational special revenues database drawer

278 rhombic plane automatizing real-time work projects capital database drawer

279 bay nat. and/or transnaitonal auditing stds., practices, methods, interps. database cabinet

280 plane automatizing real-time acct, trans, report, auditing principles database drawer

281 plane automatizing real-time acct, trans, report, auditing standards database drawer

282 plane automatizing real-time acct, trans, report, auditing interprets database drawer

283 plane automatizing real-time acct, trans, report, auditing practices database drawer

284 plane automatizing real-time acct, trans, report, auditing ethics database drawer

285 plane automatizing real-time acct, trans, report, auditing conduct rules database drawer

286 plane automatizing real-time acct, trans, report, auditing factual analysis database drawer

287 plane automatizing real-time acct, trans, report, auditing procedures database drawer

288 helix bay container presidential, congress and judicial legal history files database cabinet

289 plane automatizing u.s. pres. and congress legislative branch database drawer

290 orthorhombic plane automatizing u.s. securities act of 1933 database drawer

291 orthorhombic plane automatizing u.s. securities act of 1933 rules database drawer

292 orthorhombic plane automatizing u.s. securities act of 1933 releases database drawer

293 orthorhombic plane automatizing u.s. securities div. of corp. reg. database drawer

294 orthorhombic plane automatizing u.s. supreme court judicial branch database drawer

295 orthorhombic plane automatizing u.s. securities exchange act of 1934 database drawer

296 plane automatizing u.s. securities exchange act of 1934 rules database drawer

297 plane automatizing u.s. securities exchange act of 1934 releases database drawer

298 orthorhombic plane automatizing u.s. securities div. of corp. finance database drawer

299 helix bay of u.s. securities and/or exchange act regulatory history files database cabinet

300 orthorhombic plane automatizing u.s. securities div. of market regulation database drawer

301 orthorhombic plane automatizing u.s. securities history investigations database drawer

302 orthorhombic plane automatizing u.s. securities act of 1933 guidelines database drawer

303 orthorhombic plane automatizing u.s. securities act of 1933 filing forms database drawer

304 plane automatizing u.s. securities div. of instrument regulation database drawer

305 rhombic plane automatizing u.s. securities div. of market enforcement database drawer

306 orthorhombic plane automatizing u.s. exchange act of 1934 guidelines database drawer

307 orthorhombic plane automatizing u.s. exchange act of 1934 filing forms database drawer

308 helix bay container nat./int'l. real-time accounting, reconciling, reporting database cabinet

309 orthorhombic plane automatizing real-time u.s. sec. regulation s-x database drawer

310 plane automatizing accounting, reconciling, reporting irregularities database drawer

311 plane automatizing accounting, reconciling, reporting guidelines database drawer

312 orthorhombic plane automatizing audits and/or investigations guidelines database drawer

313 plane automatizing accounting, reconciling, reporting releases database drawer

314 orthorhombic plane automatizing real-time u.s. sec. regulation s-k database drawer

315 orthorhombic plane automatizing administrative injunction court orders database drawer

316 plane automatizing probihit, sequester, ceast-and-desist court orders database drawer

317 plane automatizing civil and/or criminal adjudication court orders database drawer

318 plane automatizing civil fines and/or punitive damage award s database drawer

319 bay nat./trans. accounting, transporting, reporting and auditing board database cabinet

320 rhombic plane automatizing real-time board authoritative statements database drawer

321 rhombic plane automatizing real-time board bulletin pronouncements database drawer

322 rhombic plane automatizing real-time board methods and ethics database drawer

323 rhombic plane automatizing real-time board rubric interpretations database drawer

324 helix bay of independent intermediary rubric pragmatic sanction database cabinet

325 rhombic plane automatizing u.s. central real-time policy statements database drawer

326 plane automatizing u.s. central real-time matching and exchanging database drawer

327 plane automatizing u.s. central intermediary board transcripts database drawer

328 plane automatizing u.s. central intermediary board facts analysis database drawer

329 rhombic plane automatizing u.s. intermediary accounting requisites database drawer

330 rhombic plane automatizing u.s. intermediary reporting requisites database drawer

331 rhombic plane automatizing u.s. long-term monetary policies database drawer

332 orthorhombic plane automatizing u.s. long-term economic policies database drawer

333 helix bay container real-time open-order data and/or info. reporting file storage

334 helix bay of real-time open-order data and/or info. reporting history file storage

335 helix bay container real-time open-order data and/or info. reporting statistics storage

336 rhombic plane real-time open-order data and/or info. reporting transmission output

337 helix bay container real-time open-order reporting data transmission file storage

338 helix bay container real-time open-order information transmission history file storage

339 bay open-order character, numeric, audio, voice, video and image transmission storage

340 bay of data, info., character, numeric, audio, voice, video, image transmission log

341 plane data, info., character, numeric, audio, voice, video, image transmission recovery

342 orthorhombic plane real-time validating data and/or information reporting station

343 helix bay container real-time validating data and/or information reporting file storage

344 helix bay container real-time validating data and/or info. reporting history file storage

345 helix bay container real-time validating data and/or info. reporting statistics storage

346 orthorhombic plane real-time validating data and/or info. reporting transmission output

347 helix bay container real-time validated data reporting transmission file storage

348 helix bay of real-time validated information reporting transmission history file storage

349 bay validated character, numeric, audio, voice, video and image transmission storage

350 helix bay data, info., character, numeric, audio, voice, video, image transmission log

351 plane data, info., character, numeric, audio, voice, video, image transmission recovery

352 factor orthorhombic plane sub-compartment parallel central microprocessor sub-unit

353 orthorhombic plane automatizing real-time treasuring data and/or info. input receiver

354 rhombic plane automatizing data and/or info. treasuring order metric conversion station

355 helix bay of automatizing data and/or info. treasuring kick out and/or undo folder

356 helix bay container real-time data and/or info. treasuring automatizing input spool reel

357 rhombic plane automatizing data and/or info. treasuring high-quality review station

358 orthorhombic plane automatizing data and/or info. treasuring system control station

359 plane real-time data and/or info. spatiotemporal treasuring tracking meter station

360 orthorhombic plane real-time data and/or info. treasuring custom control station

361 helix bay container automatizing real-time data and/or info. treasuring correction log

362 orthorhombic plane real-time automatizing data treasuring open-order match book

363 helix bay container real-time open-order data and/or info. treasuring file storage

364 helix bay container real-time open-order data and/or info. treasuring history file storage

365 helix bay container real-time open-order data and/or info. treasuring statistics storage

366 orthorhombic plane real-time open-order data and/or info. treasuring transmission output

367 helix bay container real-time open-order data treasuring transmission file storage

368 helix bay container real-time open-order info. transmission history file storage

369 bay open-order character, numeric audio, voice, video and image transmission storage

370 helix bay data, info., character, numeric, audio, voice, video, image transmission log

371 plane data, info., character, numeric, audio, voice, video, image transmission recovery

372 orthorhombic plane real-time validating data and/or information reporting station

373 helix bay container real-time validating data and/or info. treasuring file storage

374 helix bay container real-time validating data and/or info. treasuring history file storage

375 helix bay container real-time validating data and/or info. treasuring statistics storage

376 helix bay container real-time data and/or info. treasuring sys tem matching station

377 helix bay container real-time data and/or info. treasuring system clearing station

378 helix bay container real-time data and/or info. treasuring system executing station

379 helix bay container real-time data and/or info. treasuring system settling station

380 helix bay container real-time data and/or info. treasuring system exchanging station

381 helix bay container real-time treasuring, distributin, financing and digital i.d. database

382 helix bay of real-time int'l. & united states federal, state and local tax liability ledger

383 helix bay of real-time int'l. & united states federal, state and local tax liability codification

384 helix bay container real-time originating member ledger account payable data file ledger

385 helix bay container real-time targeting member ledger account receivable data file ledger

386 helix bay container real-time united states ledger entity, routing number and title ledger

387 helix bay container real-time transnational ledger entity, routing number and title ledger

388 helix bay of real-time originating member ledger account payable data file ledger

389 helix bay of real-time targeting member ledger account receivable data file ledger

390 helix bay of real-time targeting member ledger account receivable data file ledger

391 helix bay of real-time originating member ledger account payable data file ledger

392 helix bay of real-time targeting member ledger acct., routing number and title ledger

393 helix bay of real-time originating member ledger acct., routing number and title ledger

394 orthorhombic plane real-time validating data and/or info. treasuring transmission output

395 helix bay container of real-time validating data treasuring tranmission file storage

396 helix bay real-time validating information treasuring transmission history file storage

397 bay of treasuring character, numeric audio, voice, video and image transmission storage

398 helix bay data, info., character, numeric, audio, voice, video, image transmission log

399 plane data, info., character, numeric, audio, voice, video, image transmission recovery

400 orthorhombic plane automatizing real-time distributing data and/or info. input receiver

401 rhombic plane automatizing data and/or info. distributing order metric conversion station

402 helix bay container automatizing data and/or info. distributing kick out and/or undo folder

403 helix bay of real-time data and/or information distributing automatizing input spool reel

404 rhombic plane automatizing data and/or info. distributing high-quality review station

405 rhombic plane automatizing data and/or information distributing system control station

406 rhombic plane real-time data and/or info. spatiotemporal distributing tracking meter station

407 orthorhombic plane real-time data and/or information distributing custom control station

408 bay of container automatizing real-time data and/or information distributing correction log

409 orthorhombic plane real-time automatizing data distributing open-order match book

410 helix bay container real-time open-order data and/or information distributing file storage

411 bay container real-time open-order data and/or information distributing history file storage

412 bay container real-time open-order data and/or information distributing statistics storage

413 plane real-time open-order data and/or information distributing transmission output

414 helix bay container real-time open-order data distributing transmission file storage

415 helix of real-time open-order information distributing transmission history file storage

416 helix bay open-order character, numeric audio, voice, video and image transmission storage

417 bay container data, info., character, numeric, audio, voice, video, image transmission log

418 plane data, info., character, numeric, audio, voice, video, image transmission recovery

419 orthorhombic plane real-time validating data and/or information distributing station

420 helix bay of real-time validating data and/or information distributing file storage

421 helix bay of real-time validating data and/or information distributing history file storage

422 helix bay of real-time validating data and/or information distributing statistics storage

423 helix bay of real-time data and/or information distributing system matching station

424 helix bay of real-time data and/or information distributing system clearing station

425 helix bay of real-time data and/or information distributing system executing station

426 helix bay of real-time data and/or information distributing system settling station

427 helix bay of real-time data and/or information distributing system exchanging station

428 helix bay of treasuring, portfolio value(s), distributing limits, activities & digital i.d.

429 bay of wealth treasuring docs., trustee terms, provisions, portfolio restricts & digital i.d.

430 helix bay of risk mgmt: home, auto, flood, wind, boiler, prop., casualty, knp, special lines

431 bay of risk mgmt: life, medical, vision, disability, ad&d, d&o, prof. liab., work comp

432 bay of registered distributing and/or treasuring organizational financing security i.d.

433 bay new issue & secondary issue distributing, treasuring public financing offering i.d.

434 bay of registered derivative american/european option distributing instrument i.d.

435 bay of registered derivative forward, future, synthetics, warrants, swap distributing i.d.

436 bay of treasure, options, funds/edu, 401(k), IRA, pensions, loans, lease obg., tax i.d.

437 bay of registered equity, treasure, deriv., index, reit's, uit's, closed, entertain, fund i.d.

438 helix bay of treasuring, commodities, treasure covertibles, prec. metals instrument i.d.

439 helix bay of treasure, trust account, 401(k), options, new issue/second, instrument i.d.

440 plane real-time validating data and/or information distributing transmission output

441 helix bay container real-time validating data distributing transmission file storage

442 bay of real-time validating information distributing transmission history file storage

443 bay of real-time validating audio, voice, video and image transmission storage

444 bay of real-time character, numeric audio, voice, video and image transmission log

445 plane data, info., character, numeric, audio, voice, video, image transmission recovery

446 plane automatizing real-time data and/or information financing input receiver

447 plane automatizing data and/or information financing order metric conversion station

448 bay of automatizing data and/or information financing kick out/undo folder

449 bay of real-time data and/or information financing automatizing input spool reel

450 plane automatizing data and/or information financing high-quality review station

451 rhombic plane automatizing data and/or information financing system control station

452 plane real-time data and/or info. spatiotemporal financing tracking meter station

453 plane real-time data and/or information financing custom control station

454 helix bay of automatizing real-time data and/or information financing correction log

455 plane real-time open-order automatizing data and/or info. financing match book

456 helix bay of real-time open-order data and/or information financing file storage

457 helix bay of real-time open-order data and/or information financing history file storage

458 helix bay of real-time open-order data and/or information financing statistics storage

459 plane real-time open-order data and/or information financing transmission output

460 helix bay of real-time open-order data financing transmission file storage

461 helix bay of real-time open-order information transmission history file storage

462 helix bay of character, numeric audio, voice, video and image transmission storage

463 helix bay data, info., character, numeric, audio, voice, video and image transmission log

464 plane data, info., character, numeric, audio, voice, video and image trasmission recovery

465 plane spatiotemporal real-time data and/or info. tier-1 heliocentrical treasuring

466 plane spatiotemporal real-time data and/or info. tier-2 transnat./national treasuring

467 plane spatiotemporal real-time data and/or info. tier-3 state and local treasuring

468 plane real-time automatizing data and/or information financing validation station

469 helix bay of real-time validating data and/or information financing file storage

470 helix bay of real-time validating data and/or information financing history file storage

471 helix bay of real-time validating data and/or information financing statistics storage

472 plane real-time validating data and/or information financing transmission output

473 helix bay container of real-time validating data financing transmission file storage

474 helix bay of real-time validating information financing transmission history file storage

475 helix bay of character, numeric audio, voice, video and image transmission storage

476 bay of data, info., character, numeric, audio, voice, video and image transmission log

477 plane data, info., character, numeric, audio, voice, video and image trasmitting recovery

### DESCRIPTION—PREFERRED EMBODIMENTS

It is clearly an undeniable and evidentiary findings of fact, documented reference, logical scientific deduction and intutive analytical reasoning that nothing readily identified within the above aforementioned so-called relevant prior-art references recognized nor addressed the tremendously long-held and enormously heart-felt unmet needs in the relevant art, wherefrom herewith is a complete unequivocal absolute resolution hereto legal patent disclosure of proofed apprehension of a novel, unobvious, unknown, unforeseen, unprecedented, epoch, paper-less, ease of use, fruitful, opportune, never faltering and never failing panacean cutting-edge breakthrough utility engineering and groundbreaking technological architectural design innovation which is a self-contained, fault-tolerant, anonymous, independent, autonomous, impartial, apolitical, streamlined, alternating scale, and inseparable, proprietary multiport revolving chambered homing binary hunting metallic track encasing hermetic data link caster dart castings constrained new software parallel redundancy cosmos robotizing unified real-time microprocessor machine language computer block whose universal dominion domain outline is comprehensively suitable, generally pertinent and broadly useful to every and all anytime, anyplace and anywhere, wherefrom hereto entailing, encompassing, comprising, involving, impacting and/or effecting automatizing real-time holistically steady state synchronized ubiquitous continuum sub-loculated cyclical parallel redundancy cosmos robotizing unified real-time microprocessor computer logic instructions propagating, promulgating and proclaiming across-the-board traversal of breakthrough technological and groundbreaking innovative developments and advancements in multifaceted and multidimensional microcosmic techniques, designs, systems, routines, devices, manners, modes, fashions, forms, formats, factors, objects, parts, segments, elements, components, constituents, ingredients, processes, methods and combinations; wherefrom moreover hereto entailing, encompassing, comprising, involving, impacting and/or effecting streamlined, alternating scale, inseparable, seamless and natural wrapping, interlacing, coiling, coupling, combining and interlocking every and all of the following: proprietary multiport revolving chambered homing binary hunting metallic track encasing hermetic data link caster dart castings constrained new end-user graphical human apostrophe interface syntactic synthesis real-time software programs block, proprietary multiport revolving chambered homing binary hunting metallic track encasing hermetic data link caster dart castings constrained new algebraic problem-solving application syntactic synthesis real-time software programs block; proprietary multiport revolving chambered homing binary hunting metallic track encasing hermetic data link caster dart castings constrained new robotizing gauge indicating guidance syntactic synthesis real-time software programs block, proprietary multiport revolving chambered homing binary hunting metallic track encasing hermetic data link caster dart castings constrained new commerce and transactional exchange methodology syntactic synthesis real-time software programs block; proprietary multiport revolving chambered homing binary hunting metallic track encasing hermetic data link caster dart castings constrained new commerce and trade languages combinatorial syntactic synthesis real-time software programs block; wherefrom every and all proprietary creative original conceptions, engineering utilities, aesthetic architectural designs, authentic compositions and genuine productions of a sole legal owner; wherefrom herewith concretizing consummate and constructive reduction to practice a complete sub-loculated cyclical parallel redundancy cosmos robotizing real-time microprocessor machine language logic instructing compact integrated new software generator AND-OR closed-circuitry wheresoever transcendent EPROM, degausse and/or magnetostriction preemptively constrained ferromagnetic alloy, silicon, germanium, biodynamic and/or geomagnetic resonant soundproof and fireclay wall protective fireball impervious microcircuit epoxy casting insulated microprocessor engine machine language operating system computing block; wherefrom infinitely automatizing real-time holistically steady state synchronized ubiquitous continuum universal executive sub-compartment cyclical parallel redundancy cosmos robotizing real-time accurate, high-quality, never faulting, fully reliable, never failing, simplified and streamlined microprogrammable systematically codified microprocessor machine language logic instructions entailing, encompassing, comprising, involving, impacting and/or effecting every and all one-time programmable read-only memory (PROM) within a proprietary multiport revolving chambered homing binary hunting metallic track encasing hermetic data link caster dart castings constrained engine block protective contactor composite soundproof housing and fireclay sealed wall casting fireball impervious carriage data link caster dart castings accumulator controlling central processing unit (CPU) concretizing via conducive appendicular microelectronic templates appended, fixed, soldered, mounted, etched, embedded, copied, inscribed and/or contact printed onto every and all heretofore and hereafter mechanical and/or electrical devices, articles, apparatuses and/or megastructure microcircuit processing computing motherboards; wherefrom hereto intrinsic and integral as comprehensively suitable, generally pertinent and broadly useful within every and all automatizing high-quality holistically steady state heliocentrically synchronizing ubiquitous hunting continuum parallel redundancy cosmos robotizing unified real-time microprocessing computing protective contactor composite housing carriage devices, articles, apparatus, refractories and/or megastructures; wherefrom hereto successfully embroidering unequivocal absolute resolution proprietary revelatory cognizable relativistic relational melioristic logical positivism syntactic synthesis controlling central processing unit (CPU) fixture originating within every and all iota trace element minutia fueling and/or energizing microprocessor semi-conducting chips, whence perpetually propagating, promulgating and proclaiming galactic alternating angle conduit premised on a single alternating scale single independent portal proliferation of artificial semi-conducting microcircuit devices, articles, apparatuses, refractories and/or megastructures; wherefrom propagating traversal of every and all traditonal mechanical friction and/or chemical reaction to fuel power and energy conduit electrical and/or battery generation inclusive of every and all advanced electronic locational systematizing geological and/or seismological processes concretizing innovative wheresoever transcendent EPROM, degauss and/or magnetostriction preemptively constrained ferromagnetic alloy, silicon, germanium, biodynamic and/or geomagnetic resonant soundproof and fireclay wall protective fireball impervious microcircuit epoxy casting insulated permeability of artificial semi-conducting microcircuit devices, articles, apparatuses, refractories and/or megastructures internalizing upright orthorhombic tentacular boundless steady state roving antennule transmuting metric conversional transistor transfusing receiver concretizing high-quality holistically steady state heliocentrically synchronizing ubiquitous hunting continuum parallel redundancy cosmos robotizing digitalized galactic transmitting receiver of spatiotemporal emitted broadcasting of real-time microprocessing traversing a single independent portal refractory evincing minutia partible iota beta particle trace element wave front continuous spectrum pulse signaling transmission conveying efficient energizing and fueling powered catalytic conduits via electrogasdynamics, electrogenesis, electrohydraulic, geomagnetic, gyromagnetic, geokinetic and/or thermodynamic setting transistorized rheostat regulated transfusing partible trace element staple actualizing galactic and/or intergalactic gyroscopic axisymmetrical stabilizing self-impetus protective contactor composite housing carriage hermetic cast lock up software encased unified real-time microprocessor machine language computer block comprehensively suitable, generally pertinent and broadly useful within every and all portable rove bearing devices, articles, apparatuses and/or megastructures; wherefrom hereto collectively innate conception, terminological conveyance, indivisible rubric, syntactic oralformulaic, unique artwork, systematic arrangement, differentiated crafting, artistic construct, melodious lyrics, denominative literateness and thereat proprietary multiport revolving chambered binary hunting metallic track encasing hermetic lock up cast casing constrained unified real-time microprocessor machine language object block keyhole combinational software computer code heretofore and hereafter apprehends UCMOST™, information technology, heretofore formally utilized proprietary trademark and/or service mark exclusively owned intellectual property of Juan Carlos Castro. Wherefrom hereto aforementioned UCMOST™ information technology is comprehensively suitable, generally pertinent and broadly useful to streamlined, alternating scale, inseparable, seamless and natural wrapping, interlacing, coiling, coupling, combining and interlocking every and all of the distinctively separate and traditionally exclusive specialty areas of public accounting, transport reconciling, independent auditing and financial reporting inclusive of streamlined, alternating scale, inseparable, seamless and natural wrapping, interlacing, coiling, coupling, combining and interlocking every and all of the distinctively separate and traditionally exclusive specialty areas of order-entry quotation, matching, clearance, execution, settlement and exchange of insurance, risk financing, credit, cash management, investment banking and security financial instruments hereafter comprehensively across-the-board inclusive of, without limitation, public denominative words, credits, debits, monies, currencies, time deposits, escrows, trusts, individual retirements, defined pensions, deferred contributions, social security entitlements, insurance plans, insurance cooperatives, insurance rent-a-captives; insurance captives; insurance syndicates; insurance policies, annuity contracts, mutual funds, fractional equity participation interests, scrips, strips, coupons, tracking funds, unit investment trusts, real estate investment trusts, closed-end investment pools of capital, asset-backed obligations, mortgage-backed obligations, repurchase obligations, collateralized assets, collateralized liabilities, collateralized residual equities inclusive of every and all natural derivative and/or synthetic derivative, composite, indice and/or process, wherefrom further hereto comprehensively suitable, generally pertinent and broadly useful to every and all stock, bond, option, future, forward, swap, commodity, and moreover otherwise primary metal heretofore registered and licensed physical, electronic and/or virtual so-called exchanges; wherefrom further hereto inclusive of, without limitation, every and all natural, derivative and/or synthetic hard-core air and/or liquid chemical elements such as: oxygens, hydrogens; carbons; nitros; wherefrom further hereto inclusive of, without limitation, every and all natural, derivative and/or synthetic hard-core physical chemicals and/or metals such as diamonds, emeralds, rubbies, golds, silvers, coppers, irons, steels, zincs, ores, uraniums, platoniums, etc.: wherefrom further hereto inclusive of, without limitation, every and all comprehensively, generally and broadly defined authentically original, first-hand, second-hand, third-hand, intermediary and/or third party appraising, rating, assessing, zoning, permitting, licensing, designing, engineering, building, constructing, inspecting, reinspecting, developing, expanding, renovating, remodeling, refurnishing, purchasing, operating, leasing, transportring and/or outright sale entailing, encompassing, comprising, involving, impacting and/or effecting every and all, without limitation, of the following private and/or governmental zoned area space residing, operating, parking and/or in-transit tangible fixtured inclusive of intangible goodwill oriented physical personal property, residential property, commercial property and real-estate property initiatives, schemes, ocurrences, happenings, interactions, processes, methods, practices, movements, proceedings, messaging, presentations, notifications, filings, submissions, records, activities, actions, events, endeavors, tasks and affairs; and physical chemical mixtures inclusive of, without limitation, concrete, steel, asphalt, clay, brick, plaster, porcelain, graphite, titanium, synthetic graphite; wherefrom, further, atmospheric, aboveground, underground, underwater, submersible, aerospace aeronautical galactic and/or aerospace aeronautical intergalactic spatiotemporal guidance hunting emotional, pshychological, physiological, pathological, pathogenesis, cyclization, metalurgy, devises, devices, aeronautical, cosmological, typographical, oceanographical, bibliographic, physicalistic, biological cytogenetic, and ionizing natural, chemical, physical and behavioral geological, airway magnetic and/or thermomagnetic biohazardous regulated elements, components, constituents, factors, ingredients, processes, methods and/or combinations involving every and all inefficient, ineffective, disparate, dysfunctional, fragmented, antiquated, archaic, ancient history and superannuated initiatives, schemes, ocurrences, happenings, interactions, processes, methods, practices, movements, proceedings, messaging, presentations, notifications, filings, submissions, records, activities, actions, events, endeavors, tasks and affairs propagating heretofore illegitimate individualized criminality, illegitimate bibliolatrous criminality, illegitimate mafia organized criminality and/or unilateral, bi-lateral and/or multilateral transnational commissioned military armed service affairs and/or strategic covert operations hereafter effecuated exclusively via transnational validated heliocentrical exclusively remote originating and entirely finishing propagated megneton cyclometric band controlled, administered, managed and operated whereby entirely and completely sealing, encapsulating and securing every and all, without limitation, forms of recoiling reprecussion interfering explosive, damaging, detrimental, obstructing, obscurant, oppressing and/or debilitating blasts, light waves, heat waves, air waves, radio waves, artificial satellite waves, sound waves, ground waves, oceanic waves, pulsating vibrations and/or recoiling reprecussion atmospheric, aboveground, underground, abovewater, submersible, aerospace lunar galactic, aeronautical translunar galactic and/or aeronautical intergalactic partible particle beta trace element residue, fallout, earthquakes, floods, avalanches, mud slides, fire storms, magnetic storms, electrical storms, ice storms, rain storms, hail storms, thunder storms, tomoadoes, hurricanes and/or typhoons, further inclusive of, without limitatin, airway, airspace, aerospace and/or aeronautical preclusive, oppressing, repressing, obstructing, intefering and/or precluding normal transnational living standards, food supplies, water supplies, ways of life and/or walk of life econometric transactional forms, formats, standards, protocols, technologies, methodologies and/or processes which hereafter requisite normal operating real-time transmission and/or receiver transpondent transducing transitory processing and/or reprocessing attributes entailing, encompassing, comprising, involving, impacting and/or effecting which assist in further preventing every and all natural meteorlogical, electrical, accounting, communicating, transporting, energizing, reconciling, fueling, treasuring, distributing and financing real-time processing and/or reprocessing functionalities outside of the sealed, encapsulated and secured area targeted for magneton cyclometric band controlled, administered, managed and operated high-technology initiatives, schemes, ocurrences, happenings, interactions, processes, methods, practices, movements, proceedings, messaging, presentations, notifications, filings, submissions, records, activities, actions, events, endeavors, tasks and affairs; whereas, further involving every and all tangible inclusive intangible portable and/or fixtured continuous spectrum and/or orthorhombic conic section projection plane surface, nautical, ground wave, sound wave., airway, airspace, aerospace and/or aeronautical plane low-frequency, high-frequency, infrared, ultraviolet and/or geomagnetic weaponry inclusive of, without limitation, hereafter supplanting every and all so-called AEGIS, so-called Kidd-class, and so-called Kilo-class systems, heretofore utilized in, without limitation: bumptious; threatening; intimidating; tyrannizing; interfering; dehumanizing; torturing; eradicating; executing; distressing; coercing, inclusive of, without limitation, heretofore every and all: binoculars; scopes; vision eye articles; vision goggles; vision masks; vision scopes; gaseous masks; gaseous suits; bayonets; arms; guns; rifles; equalizers; ammunitions; artillery; muzzlers; star shells; ballistics; dynamites; bombs; mines; bouncing mines; mines; grenades; lasers; cannons; barrels; ions; iodines; biomechanics; bioastronautics; pathogens; magnetics; bibliotics; cytogenetics; bionics; biophysics; biochemical; hydraulics; airborne pathogens; gasses; missles; shells; rockets; stealth articles; jetfighters; jetfighters helicopters; fighter-bombers; tanks; amphibious articles; vehicles; destroyers; carriers; chambers; launchers; silencers; artificial satellites; ships; submarines; shuttles; biosatellites; capsules; pods; pads; combs; trains; silos; megastructures; robotics; bionics; apparatuses; articles; whereas, inclusive of, without limitation, every and all physical energizing and/or fueling power utility mechanical to electrical energy catalysts whether every and all standalone and/or combinatorial forms of traditional energizing and/or fueling power are concretizing via atmospheric, earth based, above sea water and/or submersible oceanic exploring, blasting, drilling, mining, extracting, piping, hauling, driving, shipping and/or airway transporting, mixing, refining, distilling, bottling and distributing and/or steam, coal, dam, gasoline, diesel, octane, mixed gasoline and oil, or propagating traverse via every and all traditonal mechanical friction and/or chemical reaction to electrical and/or rocket fuel energy via conduit electrical generation and/or electrical battery, wherefrom hereto via every and all advanced electronic locational systematizing geological and/or seismological processes concretizing innovative wheresoever transcendent EPROM, degauss and/or magnetostriction preemptively constrained ferromagnetic alloy, silicon, germanium, biodynamic and/or geomagnetic resonant soundproof and fireclay wall protective fireball impervious microcircuit epoxy casting insulated permeability of artificial semi-conducting microcircuit devices, articles, apparatuses, refractories and/or megastructures internalizing upright orthorhombic tentacular boundless steady state roving antennule transmuting metric conversional transistor transfusing receiver concretizing high-quality holistically steady state heliocentrically synchronizing ubiquitous hunting continuum parallel redundancy cosmos robotizing digitalized galactic transmitting receiver of spatiotemporal emitted broadcasting of real-time microprocessing traversing a single independent portal refractory evincing minutia partible iota beta particle trace element wave front continuous spectrum pulse signaling transmission conveying efficient energizing and fueling powered catalytic conduits via electrogasdynamics, electrogenesis, electrohydraulic, geomagnetic, gyromagnetic, geokinetic and/or thermodynamic rheostat regulated staple galactic iota minutia fueled and powered apparatuses, articles and/or megastructures; wherefrom hereto additionally inclusive of every and all of the following atmospheric multifaceted: atmospheric, aboveground, underground, underwater, submersible, aerospace aeronautical galactic and/or aerospace aeronautical intergalactic spatiotemporal sovereign private and/or governmental, real estate zoned tangible property, inclusive of, without limitation, every and all rugged, rough, economy, sport and/or luxury one-wheel, two-wheel, three-wheel, four-wheel, five-wheel, six-wheel, seven-wheel, eight-wheel, nine-wheel, ten-wheel, eleven-wheel, twelve-wheel, thirteen-wheel, fourteen-wheel, fifteen-wheel, sixteen-wheel, seventeen-wheel, eighteen-wheel and moreover every and all increasing wheel-based number inclusive of one-engine, two-engine, three-engine, four-engine, five-engine, six-engine, seven-engine, eight-engine, nine-engine, ten-engine, twelve-engine, eleven-engine, twelve-engine, thirteen-engine, fourteen-engine, fifteen-engine, sixteen-engine, seventeen-engine, eighteen-engine and furthermore every and all increasing engine-based number inclusive of one-rocket, two-rocket, three-rocket, four-rocket, five-rocket, six-rocket, seven-rocket, eight-rocket, nine-rocket, ten-rocket, twelve-rocket, eleven-rocket, twelve-rocket, thirteen-rocket, fourteen-rocket, fifteen-rocket, sixteen-rocket, seventeen-rocket, eighteen-rocket, inclusive of every and all increasing ionizing rocket-based number and/or ionizing star ships; wherefrom further, inclusive, without limitation, concretizing every and all spatiotemporal hunting axia stabilizing and equilibrating propagating never faultering and never failing, timely, safe, reliable and secure self-impetus advancing, braking, reversing, ascending, descending, driving, banking, steering, directing, turning, targeting, maneuvering, throttling, and/or controlling every and all iota minutia ionizing fuel and engery powered, thrusted and/or propelled surface-to-surface, surface-to-air and/or air-to-surface articles, apparatuses and/or megastructures via airspace, airwaves, ground waves, highway, subway, parkway, passage, toll booth, tunnel, conduit, channel, pipe, aqueduct, road, roadway, railroad and/or rail-line traverse access way space, bed, surface, pavement, traverse and/or propagating on and/or off traverse access way space inclusive of, without limitation, every and all supersonic jet, speed jet, executive jet, pleasure jet, jetliner, airliner, helicopter, snowski, waterski, cycle, car, auto, van, trailer, truck, limosine, bus, rail-line, train, vessel, ship, ferry, catamaran, freight, supertanker, carrier, module and/or shuttle aircraft, roadcraft, hovercraft, watercraft, seacraft and/or star ship transport apparatuses, articles and/or vehicles; physical communicative utilities such as electrograph, electrostatic, electrothermal, photographic, xerographic, thermographic, thermostatic, thermoelectric, telecast, teletext, teletype, televise, telefacsimile, telegraphy, telemetry, telephony, wire, cable, fiber, film, optic, glass, infrared, radio, television, cinema, radar and/or artificial satellite; inclusive of every and all basic, elementary, rudimentary, advanced and/or panacean cutting-edge combinations of natural elements, artificial elements, natural components, artificial components, natural factors, artificial factors, natural constituents, artificial constituents, natural ingredients and artificial ingredients entialing, encompassing, comprising, involving, impacting and/or effecting every and all combinatorial of the following: agriculture; construction; foods;; beverages; lumber; mining; natural resources; textiles; primary metals; fabrics; commercial machinery; computing devices; electronics; chemicals; physicals; transportation equipment; manufacturing instruments; railroad and/or transit, air, land and water transportation; communications; utilities; wholesale; retail; banking; finance; insurance; real estate; general services; public administration; non-classifiables; wherefrom further, hereto every and all aforementioned are heretofore comprehensively suitable, generally pertinent and broadly useful in apprehending and cognizably appearing, recognizing, identifying, acknowledging, associating, filtering, sorting, organizing, conceptualizing, understanding and comprehending abstract representational every and all, without limitation, real-time processing of data and/or information receiver for which every and all of every and all basic, elementary, rudimentary, advanced, ground breaking, breakthrough and/or panacean cutting-edge combinatorial elements, components, factors, constituents, ingredients, functions, constants, ratios, variables and functionalities entialing, encompassing, comprising, involving, impacting and/or effecting every and all known and unknown and/or developed and undeveloped linear and/or non-linear associative and/or sequential arithmetic, mathematical, square root, algebraic, logrithmic, spatial, aesthetic, geometrical, trigonometrical, discrete definite integer raised variable powered, calculus, statistical, advanced calculus inclusive of every and all combinatorial elements, components, factors, constituents, ingredients, functions, constants, sequences and/or variable coefficients entailing, encompassing, comprising, involving, impacting and/or effecting every and all advanced levels of symbolic notation inducing combinatorial numismatic reconciling identity matrix array mathematical, algebraic and/or factual metaanalysis combined with precision driven statistical infererences, inclusive of, without limitation, advanced differential calculus precisely evincing every and all numeric metric system dimensional descriptive figure denumerable discrete integer functions, constants, ratios, variables and functionalities, of every and all one or many wherefrom maxima and minima definite and discrete integer and integral whose integrands are undeniably, referenced, logically, scientifically and intuitively functions of independent varilables and/or dependent variables inclusive of every and all of their systematic differential variation derivatives and/or systematic differential variation synthetic derivatives, further entailing, encompassing, comprising, involving, impact and/or effecting every and all finite limits and infinite continuum differentiation and integration of every and all numeric metric system dimensional descriptive figure denumerable discrete integer functions, constants, ratios, variables and functionalities to ascertain, achieve and/or accomplish utmost conclusive evidentiary, undeniable, referenced, logical, scientific and intutive assurance entailing, encompassing, comprising, involving, impacting and/or effecting discrete and definite integer high-quality, pure integrity, real value and true assurance of utmost precision driven denumerable metric sysetm measurements, wherefrom hereto further entailing, encompassing, comprising, involving, impacting and/or effecting every and all, without limitation, real-time processing of data and/or information receiver wherefrom whichever are hereto discovered and/or concretizing as comprehensively suitable, generally pertinent and broadly useful to every and all transactional exchanges within, throughout and transcendent among the universal citizenry residing and/or operating within every and all of the so-called national sovereign borders of every and all of the industrialized, developed and developing free-market commerce and trade bloc economies within, throughout and transcending the evidentiary atmospheric geographical territories of a single holistically econometric marketplace environment, wherefrom hereto innate conception, terminological conveyance, indivisible rubric, syntactic oralformulaic, unique artwork, systematic arrangement, differentiated crafting, artistic construct, melodious lyrics, denominative literateness and thereat proprietary multiport revolving chambered binary hunting metallic track encasing hermetic lock up cast casing constrained unified real-time microprocessor machine language object block keyhole combinational software computer code heretofore and hereafter apprehends PUBLIC FINANCIALS™ instruments, proprietary trademark and service mark is exclusive proprietary intellectual property belonging exclusively and unequivocally to Juan Carlos Castro. Wherefrom every and all aforementioned PUBLIC FINANCIALS™ instruments inherently entail, encompass, compris, involve, impact and/or effect every and all whichever transactional exchange of every and all real-time processing and/or reprocessing of data and/or information receiver anytime, anyplace and anywhere within a single holistically econometric marketplace environment wherefrom hereto same terminological denominative is discovered, apprehended and concretizing as comprehensively suitable, generally pertient and broadly useful to every and all universal citizenry, wherefrom collectively moreover herewith innate conception, terminological conveyance, indivisible rubric, syntactic oralformulaic, unique artwork, systematic arrangement, differentiated crafting, artistic construct, melodious lyrics, denominative literateness and thereat proprietary multiport revolving chambered binary hunting metallic track encasing hermetic lock up cast casing constrained unified real-time microprocessor machine language object block keyhole combinational software computer code heretofore and hereafter apprehends respectively aforementioned PUBLIC FINANCIALS™ instruments necessarily integrated, critically important and increasing integral within every and information wherefrom collectively moreover herewith innate conception, terminological conveyance, indivisible rubric, syntactic oralformulaic, unique artwork, systematic arrangement, differentiated crafting, artistic construct, melodious lyrics, denominative literateness and thereat proprietary multiport revolving chambered binary hunting metallic track encasing hermetic lock up cast casing constrained unified real-time microprocessor machine language object block keyhole combinational software computer code heretofore and hereafter apprehends PUBLIC FINANCIALS™ statements, proprietary trademark and service mark is exclusive proprietary intellectual property belonging exclusively and unequivocally to Juan Carlos Castro. Moreover, respective terminological denominate combinatorial elements, components, factors, ingredients and/or constituents aforementioned PUBLIC FINANCIALS™ instruments inclusive of every and all necessarily integrated, critically important and increasingly integral aforementioned PUBLIC FINANCIALS™ statements further undeniably, logically, scientifically and intuitively derives comprehensively suitable, generally pertinent and broadly useful syntactic synthesis in further apprehending and cognizably appearing, recognizing, identifying, acknowledging, associating, filtering, sorting, organizing, conceptualizing, understanding and comprehending every and all heretofore known and/or unknown inclusive of every and all developed and/or undeveloped concretizing abstractive conceptualized representational tangible and/or intangible literary, melioristic logical positivism, melodius, theatrical, aesthetic and artistic works inclusive of, without limitation, every and all of the following: high technology; identic; diplomatics; scientistic; thoughts; notions; ideas; concepts; conceptions; devises; devices; metaphysics; metaanalysis; philosophies; metaethic; elemental; object; rudimentary; methodical; robotics; philology; geological; horological; typology; typography; magnetic levitation; magneton; ecological; econometrics; existentials; metrology; meteorological; metamathematical; geometries; numismatics; heuristics; identic; linguistic; metaphysical; metalurgy; nautical; astrological; cosmological; bibliographic; oceanographic; astronomical; aeronautical; ufology; chemical; ionizing; biologic; pathogenic; sociological; cytogenetic; commerce; governance; law; medicine; social contract; social engineering; social psychiatry; social psychology; social science; social service; social geography; social history; social governance; sociobiological; sociocultural; social economic; sociolinguistic; sociometry; sociopolitical; socioreligious; theological; sociopsychologica; paleoecology; paleography; anthropical; phytological; behavioral; pathological; physiological; pyschological; metalography; phonetic; physicalistics; zoology; metalinguistics; and/or other heretofore utilization of antiquated, archaic, ancient history and superannuated identifying, organizing, categorizing, indexing, cataloging and/or processing cards, records, files, folers, disks, dishes, drives, cabinets, drawers, shelves or otherwise entailing, encompassing, comprising, involving, impacting and/or effecting hesistant, restricting, restraining, delayed, time-lagged, antiquated, archaic, ancient history and superannuated methodological pooling and batch group processing transmission to/from converting reciever traverse conduit data transport processing heretofore concretizing cognizably appearing, recognizing, identifying, acknowledging, associating, filtering, sorting, organizing, conceptualizing, understanding and/or comprehending all of whose inherent aim, letter, nature, breadth, sound, depth, spirit and scope benefits from efficiencies herewith useful via invoking aforementioned UCMOST™ information technology, every and all of which entail, encompass, comprise, involve, impact and/or effect concretizing across-the-board and/or across national so-called border traversal, without limitation, of every and all of the tens of hundreds of thousands of the following: so-called proprietary holding; so-called proprietary fixtured; so-called partnership holding; so-called partnership fixtured; so-called company holding; so-called company fixtured; so-called firm holding; so-called firm fixtured; so-called corporation holding; so-called corporation fixtured; so-called incorporation holding; so-called incorporation fixtured; so-called commercial holding; so-called commercial fixtured; so-called franchise holding; so-called franchise fixtured; so-called union holding; so-called union fixtured; so-called thrift holding; so-called thrift fixtured; so-called group holding; so-called group fixtured; so-called board holding; so-called board fixtured; so-called institute holding; so-called institute fixtured; so-called convention holding; so-called convention fixtured; so-called bi-cameral holding; so-called bicameral fixtured; so-called society holding; so-called society fixtured; so-called chamber holding; so-called chamber fixtured; so-called convention holding; so-called convention fixtured; so-called summit holding; so-called summit fixtured; so-called not-for-profit holding; so-called not-for-profit fixtured; so-called foundation holding; so-called foundation fixtured; so-called endowment holding; so-called endownment fixtured; so-called association holding; so-called association fixtured; so-called league holding; so-called league fixtured; so-called consortium holding; so-called consortium fixtured; so-called commission holding; so-called commission fixtured; so-called agency holding; so-called agency fixtured; so-called bureau holding; so-called bureau fixtured; so-called department holding; so-called department fixtured; so-called court holding, so-called court fixtured; so-called embassy holding; so-called embassy fixtured; so-called section holding; so-called section fixtured; so-called town holding; so-called town fixtured; so-called locale holding; so-called locale fixtured; so-called city holding; so-called city fixtured; so-called municipal holding; so-called municipal fixtured; so-called metropolis holding; so-called metropolis fixtured; so-called county holding; so-called county fixtured; so-called district holding; so-called district fixtured; so-called province holding; so-called province fixtured; so-called state holding; so-called state fixtured; so-called federal holding; so-called federal fixtured; so-called country holding; so-called country fixtured; so-called nation holding; so-called nation fixtured; so-called transnational holding; so-called transnational fixtured; so-called multinational holding; so-called multinational fixtured; so-called transnational holding; so-called transnational fixtured; so-called federation holding; so-called federation fixtured; so-called confederation holding; so-called confederation fixtured; whichever private individuals, private and/or public commercial, labor unionized, religious sect, political ideological, group and/or board associational and/or public governance legal and/or status of existence below mentioned members of a universal citizenry, every and all of whom are respectively, independently, autonomously, evidently, undeniably, logically, scientifically and intuitively found to be inevitably necessary and increasingly integral living and breathing biological organisms within a capital market heretofore and hereafter irrespective of whether whichever resides and/or operates heretofore and hereafter anytime, anywhere and anyplace within, throughout and/or transcending whichever geographical territories of a single holistically econometric marketplace environment, wherefrom hereto collectively innate conception, terminological conveyance, indivisible rubric, syntactic oralformulaic, unique artwork, systematic arrangement, differentiated crafting, artistic construct, melodious lyrics, denominative literateness and thereat proprietary multiport revolving chambered binary hunting metallic track encasing hermetic lock up cast casing constrained unified real-time microprocessor machine language object block keyhole combinational software computer code heretofore and hereafter apprehends PUBLIC FINANCIALS™ organizations, proprietary trademark and service mark is exclusive proprietary intellectual property belonging exclusively and unequivocally to Juan Carlos Castro. Wherefrom every and all aforementioned PUBLIC FINANCIALS™ organizations are necessarily involved, directly and/or indirectly, in producing, promoting and/or distributing products, goods, supplies and/or services entailing, encompassing, comprising, involving, impacting and/or effecting comprehensively suitable, generally pertinent and broadly useful individualize and/or combinatorial elements, components, factors, ingredients, constituents and/or integral associatives comprehensively suitable, generally pertient and broadly useful albeit somewhat limiting characterized as classifications, categorizations and/or stratifications entailing, encompassing, comprising, involving, impacting and/or effecting every and all, without limitation, natural derivative and/or synthetic: agriculture; construction; foods; beverages; lumber; mining; natural resources; primary metals; textiles; fabrics; machinery; computing articles; computing devices; computing hardware; computing software; electronical conduits; transportation equipment; manufacturing instruments; railroad, train, transit, air, land and/or water transportation equipment; all communications; fuel, enery and power utilities; wholesale; retail; banking; finance; insurance; real estate; general services; non-classifiable; public administration; and/or national security functions, variables and/or functionalities entailing, encompassing, comprising, involving, impacting and/or effecting every and all, without limitation, governing, legal, accounting, financing, auditing, reporting, and/or exchange heretofore via so-called wide-spread, annoying, raptorial, voracious, unfruitful, unmerciful, boisterous, bolstering, unsubstantiated, unnecessary, unwarranted, unmitigated and unjustifiable marketing, advertising, promoting, propitiating, soliciting, associating and/or sponsoring via every and all inefficient, ineffective, disparate, dysfunctional, fragmented, antiquated, archaic, ancient history and superannuated initiatives, schemes, ocurrences, happenings, interactions, processes, methods, practices, movements, proceedings, messaging, presentations, notifications, filings, submissions, records, activities, actions, events, endeavors, tasks and affairs, without limitation, comprehensively, generally and braodly entailing, encompassing, comprising, involving, impacting and/or effecting every and all, without limitaton, of the following: information; scooping; headlining; news; commercials; advertisements; silkiers; notices; intertwining; messaging; mailing; articles; fliers; circulars; letters; directing; twisting; proping; webpaging; researching; developing; convoluting; designing; uploading; posting; hosting; cooking; searching; downloading; dialoguing; streaming; spamming; slamming; cramming; churning; dumping; gouging; discounting; allowing; rebating; couponing; propagandizing; refunding; enticing; coupling; splitting; commissioning; auctioning; pitting; tipping; speeding; slouching; slipping; inducing; motivating; lynching; hanging; defaming; fatiguing; beheading; miring; returning; specializing; discounting; discoursing; conspiring; contriving; devising; conversing; prying; peeping; viewing; hacking; linking; mixing; releasing; pressing; updating; headlining; reportings; announcing; pronouncing; promoting; sponsoring; propitiating; soliciting; contracting; traces; editorials; newsletters; coiling; newspapers; periodicals; publications; magazines, wherefrom whichever and whenever hereafter naturally evincing and requisiting every and all, without limitation, conceived, created, engineered, designed, development, and hereto concretizing via consummate melioristic logical positivism devotional praxis and timely constructive reduction to practice UCMOST™ real-time processing and/or reprocessing. Wherefrom, moreover hereto, without limitation, UCMOST™ real-time processing and/or reprocessing is logically comprehensively suitable, generally pertinent and broadly useful wherever entailing, encompassing, comprising, involving, impacting and/or effecting every and all private and/or public commercial, associational, town, locale, city, municipal, metropolis, district, province, state, federal, country, nation, transnational, multinational, transnational, federation and/or confederation governmental reasearch, development, planning, building, construction, startup, operations, management, upkeep and/or dissolving within aforementioned PUBLIC FINANCIALS™ organizations slumbery, suburbanized and/or high-society areas, people, places and/or things inclusive of, without limitation, every and all aforementioned PUBLIC FINANCIALS™ organizations transportation, living, dwelling, working, educational, playing, sporting, gaming, recreational, nutritional, entertainment, health, safety, prevention, policing, inspection, fitness, nutritional, rehabilitation, correctional, retirement and sight-seeing pleasure, business, public and/or instruction tour dwellings, buildings, facilities, complexes and constructs; wherefrom hereto undeniably, logically, scientifically and intuitively necessarily whichever requisite every and all integrated and integral traditional and/or alternative water and sewer, utility lighting and fueled energy power including, without limitation every and all necessary communicative utilities applicable to, without limitation, every and all aforementioned PUBLIC FINANCIALS™ organizations building and construction architectural design and structural engineering inclusive of, without limitation, every and all building and construction development and implementation of every and all of the following: public access air space vehicular transports; public access roadbed vehicular transports substructure surface roadbed pavement research, engineering, development and construction; public access waterway vehicular transports; high-way, aboveground and/or underground vehicular public access way transport substructure surface roadbed pavement research, engineering, developments and constructions; public access roadway upright orthorhombic rhombus traverse vehicular transport light-postings; public access roadway sideway orthorhombic rhombus traverse vehicular transport guard-railings; public access roadway surface orthorhombic rhombus traverse vehicular transport painting right of way directional directives signaling propagations; public access roadway curbside orthorhombic rhombus traverse vehicular transport painting right of way directional directives signaling propagations; public access roadway roadbed orthorhombic rhombus traverse vehicular transport surface pavement; public access roadway roadbed orthorhombic rhombus upright traverse vehicular transport directional directives locative signaling propagations; private and/or public spaces, sport and play parks, civic centers, arenas, sites, atriums, buildings, stadiums and/or arenas comprehensively suitable, generally pertinent and broadly useful to public service, theatrical, sporting, recreational, nutritional, entertainment, business and/or eductional purpose dwellings; private and/or public slumbery apartment building facilities and complex housing dwellings; private and/or public suburbanized resident town home dwellings; private and/or public midde-class suburbanized residential property home dwellings; high-society suburbanized residential property; private and/or public commercial workplace productivity suburbanized and downtown dwellings; private and/or public commercial products showplace dwellings; private and/or public commercial merchandising showplace dwellings; private and/or public commercial health, well-being, retirement, pharmaceutical and/or nutritional productivity dwellings; private and/or public commercial workplace productivity perpendiular upright traverse elevator dwellings; private and/or public commercial workplace productivity upright orthorhombic traverse walkway dwellings; private and/or public public service, theatrical, sporting, recreational, nutritional, health, rehabilitation, correctional, entertainment, business and/or eductional purpose dwellings; inclusive of private and/or public commercial foods, goods, products, supplies and/or services inclusive of every and all of the following: nutritional packaged goods, perishable vegetables, perishable poulty, perishalbe meats, perishable foods inclusive of every and all health, health related packaged prescription medications, mental health, remedial rehabilitation, criminal correctional, pharmaceutical, hygiene, janitorial, fabrics, uniform garmets, foods, beverages, packaged alcoholic beverages, packaged preferential cigarettes, packaged alcoholic wine and spritz, inclusive of, without limitation every and all other heretofore known and/or unknown, developed and/or undeveloped packaged cosmetics wherefrom hereto every and all necessarily requisite market research, development, planning, capitalizing, promoting, building, construction, startup, operations, management, upkeep and/or dissolving which potentially requisite every and all of the following: purchasing, construction, development, upkeep, operating, leasing and/or sales permits; purchasing, construction, development, upkeep, operating, leasing and/or sales licenses; purchasing, construction, development, upkeep, operating, leasing and/or sales assessments; purchasing, construction, development, upkeep, operating, leasing and/or sales rates; purcahse, operating and/or leasing fees; purchasing, construction, development, upkeep, operating, leasing and/or sales chages; purchasing, construction, development, upkeep, operating, leasing and/or sales surcharges; purchasing, construction, development, upkeep, operating, leasing and/or sales tariffs; purchasing, construction, development, upkeep, operating, leasing and/or sales costing; purchasing, construction, development, upkeep, operating, leasing and/or sales price listing; purchasing, construction, development, upkeep, operating, leasing and/or sales sales pricing; purchasing, construction, development, upkeep, operating, leasing and/or sales coupon rebating; purchasing, construction, development, upkeep, operating, leasing and/or sales coupon refunding; purchasing, construction, development, upkeep, operating, leasing and/or sales discounting; purchasing, construction, development, upkeep, operating, leasing and/or sales allowing; purchasing, construction, development, upkeep, operating, leasing and/or sales redemptions; purchasing, construction, development, upkeep, operating, leasing and/or sales taxes; purchasing, construction, development, upkeep, operating, leasing and/or sales power; purchasing, construction, development, upkeep, operating, leasing and/or sales energy; purchasing, construction, development, upkeep, operating, leasing and/or sales parts; purchasing, construction, development, upkeep, operating, leasing and/or sales accessories; purchasing, construction, development, upkeep, operating, leasing and/or sales fixtures; purchasing, construction, development, upkeep, operating, leasing and/or sales amenities; purchasing, construction, development, upkeep, operating, leasing and/or sales luxuries; purchasing, construction, development, upkeep, operating, leasing and/or sales inspections; purchasing, construction, development, upkeep, operating, leasing and/or sales insurances; purchasing, construction, development, upkeep, operating, leasing and/or sales assurances; purchasing, construction, development, upkeep, operating, leasing and/or sales warranties; purchasing, construction, development, upkeep, operating, leasing and/or sales contractual arrangements; purchasing, construction, development, upkeep, operating, leasing and/or sales property assessments; purchasing, construction, development, upkeep, operating, leasing and/or sales blueprints; purchasing, construction, development, upkeep, operating, leasing and/or sales designs-, purchasing, construction, development, upkeep, operating, leasing and/or sales workflow charts; purchasing, construction, development, upkeep, operating, leasing and/or sales security systems; purchasing, construction, development, upkeep, operating, leasing and/or sales property redemption assessements; purchasing, construction, development, upkeep, operating, leasing and/or sales property sub -easing assignments; purchasing, construction, development, upkeep, operating, leasing and/or sales property sale assessments; wherefrom hereto whichever also necessarily potentially requite every and all musical, opera, play, drama, travesty, horror, tragedy, comedy, animation, action, porn, science-fiction and/or theatrical copious works of literary, theatrical, melodius, artistic, sporting, eductional, pleasure, recreational and entertainment audio, video, voice, visual, graphic and/or image compositions, productions, performances, solicitations, promotions, commercials, advertisements, promulgations and/or propagations potential entailing, encompassing, comprising, involving, impacting and/or effecting every and all of the following: transportation, living, working, educational, playing, sporting, recreational, nutritional, entertainment, health, safety, prevention, water and sewer, utilities, policing, inspection, fitness, rehabilitation, correctional, retirement and/or sightseeing tour dwelling, public access ways and/or public access way media potentially inclusive of every and all of the following: physical governance magistrate legal, regulatory, contractual, employment, civil, penal, punitive, statutory and/or criminal apprehensions, injuctions, suits, indictments, subpoena, writ, claims, declarations, depositions, discoveries, patents, proceeedings, grand juries, trials, mock trials, summary judgments, plea bargain settlements, currency settlements, arbitrations, mediations, damages, awards, adjudications, pardons and/or time-served adjustments; physical governance elective and/or appointed legislative, executive, judicial, political, economic, currency, fiscal, monetary, accounting, auditing, reporting, elective and/or arbitrarily imposed licenses, taxes, rates, assessments, charges, fees, tariffs, sur-charges, inclusive of every and all sales taxes, income taxes, alternative minimum taxes, capital gains taxes, death rate taxes, estate rate taxes, probate rate taxes, marriage rate taxes, inclusive of import/export clearance inventory tariff and trade licenses, taxes, rates, assessments, charges, fees, tariffs, sur-charges, further inclusive of, without limitation, every and all whichever vehicle emission controls, police authorities, vehicle registrative controls, vehicle pool management, vehicle pool maintenance, general public copious works, general parks and recreations, general airport authorities, generald-port authorities, general sea-port authorities, housing and development, economic development, welfare services, child endangerment services, health and nutrional services, fire protection and inspective authorities, building code construction inspective authorities, police protection and inspective authorities, national defense and national security, general vehicle damage, loss and injury inspections, general vehicle roadway speed inspective authorities, general public water management, general public sewer maintenance, general public police housing construction, wherefrom hereto whichever requiting transactional exchange data collectively aforementioned PUBLIC FINANCIALS™ instruments inclusive of every and all necessarily integrated, critically important and increasingly integral associative and/or differential definite integrer denumerable metric system precise measurements from which every and all real-time processing and/or reprocessing of data and/or information receiver is comprehensively suitable, generally pertinent and broadly useful entailing, encompassing, comprising, involving, impacting and effect every and all necessarily derivative data retrieval and/or information retreieval inclusive of data reretrieval and/or information reretrieval accumulator generated aforementioned PUBLIC FINANCIALS™ statements. Wherefrom further hereto whichever actualizing a novel unobvious, unknown, unforeseen, unprecedented, epoch, paper-less, ease of use., fruitful, opportune, never faltering and never failing panacean cutting-edge breakthrough utility engineering and groundbreaking technological architectural design innovation comprehensively suitable, generally pertinent and broadly useful to every and all aforementioned PUBLIC FINANCIALS™ instruments inclusive of every and all necessarily integrated, critically important and increasingly integral aforementioned PUBLIC FINANCIALS™ statements wherefrom hereto whichever private individuals, private and/or public commercial, labor unionized, religious sect, political ideological, group associational and/or public governance legal status of existence within the universal populace whom are further respectively, independently, autonomously, evidently, undeniably, logically, scientifically and intuitively found to be inevitably necessary and increasingly integral member participants within a capital market of the holistically economic marketplace environment inclusive of, without limitation, every and all of the heretofore tens of hundreds of thousands inclusive of heretofore and herefater tens of hundreds of millions whichever principles, standards, interpretations, practices, theories, philosophies, disertating, counseling, advising, guiding, recommending, representing, courts, trials, appeals, council, forum, arbitration, mediation, diplomatics, summits, diplomacies, agreements, accords, partnerships, companies, firms, incorporations, mergers, treaties, treaty, session, consortium, bicameral, committee, cabinet, commission, convention, declaration, doctrine, constitution, amendment, patent, congressional, legislature, executive and/or judicial jurisdictional transactional exchange initiatives, schemes, ocurrences, happenings, interactions, processes, methods, practices, movements, proceedings, messaging, presentations, notifications, filings, submissions, records, activities, actions, events, endeavors, tasks and affairs whichever irrespective of whether occuring, happening and/or transpiring residually and/or occuring, happening and/or transpiring spontaneously therein further every and all whose inherent aim, letter, nature, breadth, sound, depth, spirit and scope herewith invokes, without limitation, across-the-board traversal of every and all of the tens of hundreds of thousands of the aforementioned PUBLIC FINANCIALS™ organizations. Wherefrom every and all whichever heretofore and hereafter tens of hundreds of thousands of aforementioned PUBLIC FINANCIALS™ organizations respectively, independently, autonomously, evidently, undeniably, logically, scientifically and intuitively are hereto discovered to be inevitably necessary and increasingly integral living and breathing biological organisms within a capital market transmuting every and all multifaceted industries and multidimensional sectors of the industrialized, developed and developing free-market commerce and trade blocs within, throughout and transcending every and all whicever geographical territories of a single holistically econometric marketplace environment, wherefrom hereto every and all are hereby necessarily concretizing as streamlined, alternating scale, inseparable, seamless and naturally wrapped, twisted, convoluted, coupled and combined heretofore and hereafter as combinatorial with every and all, without limitation, of the following: so-called premature infants; so-called immature infants; so-called immature toddlers; so-called immature children; so-called immature child students; so-called immature adolescents; so-called immature adolescence students; so-called mature adults; so-called academic students; so-called independent writers; so-called independent bibliographers; so-called independent photographers; so-called independent investigators; so-called independent editors; so-called independent reporters; so-called independent publishers; so-called independent printmakers; so-called independent advertisers; so-called independent marketers; so-called independent manufacturers; so-called independent farmers; so-called independent owners; so-called independent labor personnel; so-called independent distributors; so-called independent resellers; so-called independent composers; so-called independent developers; so-called independent producers; so-called independent artists; so-called independent preachers; so-called independent philosophers; so-called independent inventors; so-called appointed managers; so-called elected mayors; so-called elected commissioners; so-called elected state congress representatives; so-called elected state congress senators; so-called elected state governors; so-called elected national congress representatives; so-called elected national congress senators; so-called elected national presidents; so-called elected jurisprudential district judges; so-called appointed jurisprudential state judges; so-called appointed jurisprudential circuit judges; so-called appointed jurisprudential national judges; so-called appointed national jurisprudential generals; so-called elected state jurisprudential generals; so-called appointed national civil service commissioners; so-called appointed national civil service representatives; so-called elected state civil service commissioners; so-called appointed state civil service representatives; so-called appointed polity party bureaucratic officials; so-called civil service bureaucratic representatives; so-called civil service bureaucratic managers; so-called civil service correctional labor personnel; so-called civil service correctional representatives; so-called civil service correctional officials; so-called elected civil service jurisprudential investigative officials; so-called civil service commissioned jurisprudential investigative officers; so-called civil service commissioned jurisprudential investigative assistants; so-called independent commercial private correctional officers; so-called commercial private service investigators; so-called civil service rehabilitation representatives; so-called civil service rehabilitation managers; so-called civil service rehabilitation officials; so-called commercial rehabilitation representatives; so-called commercial rehabilitation managers; so-called commercial rehabilitation officials; so-called appointed civil service administrative wardens; so-called appointed commercial administrative wardens; so-called civil service labor personnel; so-called drafted military armed services labor personnel; so-called enlisted military armed services labor personnel; so-called enlisted military armed services non-commissioned personnel; so-called enlisted military armed services noncommissioned personnel correctional officers; so-called enlisted military armed services non-commissioned correctional wardens; so-called enlisted military armed services noncommissioned personnel rehabilitation officers; so-called enlisted military armed services non-commissioned personnel rehabilitation wardens; so-called enlisted military armed services non-commissioned rehabilitation pharmacologsts; so-called enlisted military armed services non-commissioned medical physician doctors; so-called enlisted military armed services non-commissioned sergeants; so-called enlisted military armed services non-commissioned staff sergeants; so-called enlisted military armed services non-commissioned master staff sergeants; so-called military armed services commissioned lieutenant officers; so-called military armed services commissioned lieutenant commanders; so-called military armed services commissioned captain officers; so-called military armed services commissioned major officers; so-called military armed services commissioned lieutenant colonel officers; so-called military armed services commissioned colonel officers; so-called military armed services commissioned field-grade officers; so-called military armed services commissioned brigadier general officers; so-called military armed services Uniform Code of Military Justice (UCMJ); so-called military armed services commissioned jurisprudential investigators; so-called military armed services commissoned jurisprudential practicioners; so-called military armed services commissioned jurisprudential jurists; so-called acknowledged assistant teachers; so-called certified teachers; so-called acknowledged associate professors; so-called tenured professors; so-called tenured jurisprudential scholars; so-called licensed jurisprudential practitioners; so-called tenured medical physician scholars; so-called licensed medical physician doctors; so-called accounting professor scholars; so-called certified accounting practitioners; so-called auditing professor scholars; so-called certified auditing practitioners; so-called commercial business professor scholars; so-called commercial business practitioners; so-called financing professor scholars; so-called financing practitioners; so-called scientists; so-called chemists; so-called physicists; so-called licensed psychologists; so-called licensed medical physician pschiatrists; so-called acknowledged associate pharmacists; so-called licensed pharmacologists; so-called unordained clericalists; so-called ordained clericalists; so-called politicking party members; so-called society inductees; so-called chamber representatives; so-called convention members; so-called summit participants; so-called commercial service labor personnel; so-called consumers; so-called member-subscribers; so-called customers; so-called clients; so-called constituents; so-called debtors; so-called creditors; so-called shareholders; so-called stakeholders; so-called U.S. depositors; so-called U.S. citizen taxpayers; so-called foreign national depositors; so-called foreign national taxpayers; so-called princeship; so-called princesses; so-called dukes; so-called dukesses; so-called ambassadors; so-called diplomats; so-called monarchs; so-called global depositors; so-called domestic citizenry; so-called foreign citizenry; so-called domestic retiree citizenry; so-called foreign retiree citizenry; so-called general populace; wherefrom every and all, without limitation, of whom are also respectively, independently, autonomously, evidently, undeniably, logically, scientifically and intuitively found to be inevitably necessary and increasingly integral living and breathing biological organisms within a capital market, heretofore and hereafter irrespective of whether whichever resides and/or operates heretofore and hereafter anytime, anywhere and anyplace within, throughout and/or transcending whichever geographical territories of a single holistically econometric marketplace environment, wherefrom moreover every and all whose inherent aim, letter, nature, breadth, sound, depth, spirit and scope herewith invokes, without limitation, across-the-board traversal of every and all of the hundreds of millions undeniably, evidentiary, logically, scientifically, intutively and necessarily depositors inclusive of undeniably, evidentiary, logically, scientifically, intutively and necessarily investors involving holding and/or fixtured in aim, letter, nature, spirit, scope, breadth and depth: so-called proprietary; so-called partnership; so-called company; so-called firm; so-called corporation; so-called incorporation; so-called commercial; so-called franchise; so-called union; so-called thrift; so-called group; so-called board; so-called institute; so-called convention; so-called bi-cameral; so-called society; so-called chamber; so-called convention; so-called summit; so-called not-for-profit; so-called foundation; so-called endowment; so-called association; so-called league; so-called consortium; so-called commission; so-called agency; so-called bureau; so-called department; so-called court; so-called embassy; so-called section; so-called town; so-called locale; so-called city; so-called municipal; so-called metropolis; so-called county; so-called district; so-called province; so-called state; so-called federal; so-called country; so-called nation; so-called transnational; so-called multinational; so-called transnational; so-called federation; so-called confederation; whichever private individuals, private and/or public commercial, labor unionized, religious sect, political ideological, group associational and/or public governance legal and/or status of existence above and below mentioned are undeniably, evidentiary, logically, scientifically and intuitively members of a universal citizenry, every and all of whom further, without limitation, are respectively, independently, autonomously, evidently, undeniably, logically, scientifically and intuitively found to be inevitably necessary and increasingly integral members of a capital market, heretofore and hereafter irrespective of whether whichever resides and/or operates anytime, anywhere and anyplace within, throughout and/or transcending whichever geographical territories of a single holistically econometric marketplace environment, wherefrom hereto innate conception, terminological conveyance, indivisible rubric, syntactic oralformulaic, unique artwork, systematic arrangement, differentiated crafting, artistic construct, melodious lyrics, denominative literateness and thereat proprietary multiport revolving chambered binary hunting metallic track encasing hermetic lock up cast casing constrained unified real-time microprocessor machine language object block keyhole combinational software computer code heretofore and hereafter apprehends UNIVESAL POPULACE™, proprietary trademark and service mark is exclusive proprietary intellectual property belonging exclusively and unequivocally to Juan Carlos Castro. Wherefrom terminological denominate syntactic synthesis invoking aforementioned UCMOST™ information technology is comprehensively suitable, generally pertinent and broadly useful to every and all, without limitation, aforementioned PUBLIC FINANCIALS instruments hereto harnessed, wrapped, leveraged and unequivocally apprehended in connection with every and all, without limitation, of the aforementioned PUBLIC FINANCIALS™ statements from every and all individual members of the aforementioned UNIVERSAL POPULACE™ which are heretofore and hereafter undeniably, logically, scientifically and intuitively comprehensively suitable, generally pertient and broadly useful to every and all real-time processing and/or reprocessing of data and/or information receiver entailing, encompassing, comprising, involving, impacting and/or effecting every and all asset, liability and residual equity ledger balance accounts of every and all private individuals inclusive, without limitation, of every and all public organizations within, throughout and transcending the national sovereign so-called borders of every and all of the industrialized, developed and developing free-market commerce and trade bloc economies within a single holistically econometric marketplace environment; wherefrom whichever further entailing, encompassing, comprising, involving, impacting and/or effecting every and all legal interstate and/or intrastrate Uniform Commercial Code (UCC), inclusive of legal transnational and/or transnational commercial mercantile free-trade agreements transcending national sovereign so-called borders of trade block economies, inclusive of, without limitation, every and all utility and design innovation stemming from effortless reseach development and technological advancement whereby mitigating every and all polarizing situations and/or unnecessary concerns involving: the Anti-Ballistic Misssle Treaty; the North American Free Trade Agreement (NAFTA); the European Economic Union (EEU); the Asian-Pacific Economic Community (APEC); wherefrom aforementioned PUBLIC FINANCIALS™ statements from every and all individual members of the aforementioned UNIVERSAL POPULACE™ which are heretofore and hereafter undeniably, logically, scientifically and intuitively comprehensively suitable, generally pertient and broadly useful to every and all real-time processing and/or reprocessing of data and/or information receiver entailing, encompassing, comprising, involving, impacting and/or effecting every and all ledger trace account, trial balance, cash flow, profit and loss and/or balance sheet; wherefrom whichever inherently, intrinsically, clearly, undeniably, logically, scientifically and intutively deriving and/or driving every and all personal financial statement inclusive of, without limitation, every and all public statement of revenue, cost of goods sold, depreciation expenditure, other operational expenditure, interest expenditure if applicable, taxes payable and/or deferred taxes payable, and residual profit if available, public statement of financial position or so-called public balance sheet, and public statement of cash flows inherently derived from every and all cash inflow and/or outflow from ledger account receivables, ledger account payables, acquisitions of property, plant, boiler and machinery equipment, ledger account short-term borrowing, ledger account long-term borrowing, new residual equity issuance and potential payment of dividends which occur, happen and/or transpire respectively from accounting, operating, exchanging, administrating, reconciling, managing and financing, inclusive of, without limitation, every and all distinctively separate and traditionally exclusive private and/or public off-balance sheet statement of financial position whichever owned as majority and/or minority participations, wherefrom further hereto every and all of which entail, encompass, comprise, involve, effect and impact every and all current and long-term ledger account asset receivable balances, ledger account asset Universal Character Set (UCS) and/or Universal Decimal System (UDS) driven and/or effectuated Universal Product Code (UPC) inventory balances, ledger account asset or potentially liability balances, ledger account other long-term asset balances, ledger account liability payable balances, ledger account interest liability payable balances, ledger account other long-term liability payable balances, ledger account additional paid-in capital residual equity balances, ledger account structural capitalization residual equity balances, and other ledger account alternative structural capitalization residual equity balances, wherefrom further hereto every and all entail, encompass, comprise, involve, effect and impact every and all assets, liabilities and/or residual equities from private and/or public sub-unit, unit, divisional, segmented and/or consolidated elements, components, factors, constituents and ingredients comprising aforementioned PUBLIC FINANCIALS™ statements which inherently involve multifaceted and multidimensional non-financial account headings and non-financal contra-account headings entailing, encompassing, comprising, involving, impacting and/or effecting intrinsically and inherently, without limitation, every and all real-time processing and/or reprocessing of data and/or information receiver from every and all general populace, elected officials, appointed dignitaries, appointed diplomats, public/private organizations, sovereign government entities and/or not-for-profit organizations all of whom are respectively, independently, autonomously, evidently, undeniably, logically, scientifically and intuitively found to be inevitably necessary and increasingly integral member participants within a single holistically econometric marketplace environment. It is clearly an undeniable and evidentiary findings of fact, documented reference, logical scientific deduction and intuitive analytical reasoning that whichever respective aforementioned PUBLIC FINANCIALS™ instruments inclusive of necessarily integrated, critically important and increasingly integral aforementioned PUBLIC FINANCIALS™ statements from members of the aforementioned UNIVERSAL POPULACE™ whichever are furthermore undeniably, logically, scientifically and intuitively herewith deduced, apprehended and invoked from every and all necessarily integrated, critically important and increasingly integral entities, beings, elements, components, factors, constituents and ingredients within members of the aforementioned UNIVERSAL POPULACE™ for which apprehending and concretizing an innovative unequivocal absolute resolution solution invoked within aforementioned UCMOST™ information technology; which are herewith evinced as instrinsically, integrally and comprehensively suitable, generally pertinent and broadly useful to streamlining and integrating every and all ideas, matters, issues, events, movements, calendrical, dialogues, discourses, occurences, transpiring, happening, happenstance, discovering, concepts, principles, standards, interpretations, practices, theories, philosophies, disertating, counseling, advising, guiding, recommending, representing, courts, trials, appeals, council, forum, arbitration, mediation, diplomatics, summits, diplomacies, agreements, accords, members of the aforementioned UNIVERSAL POPULACE™ legal reapportionment definitive discrete integer numeric metric system figure tabulating elective propagations; wherefrom furthermore, hereto members of the aforementioned UNIVERSAL POPULACE™ legal appropriation definitive discrete integer numeric metric system figure tabulating elective propagations; wherefrom moreover hereto members of the aforementioned UNIVERSAL POPULACE™ legal emergency planning definitive discrete integer numeric metric system figure tabulating emergency standy workforce elective propagations; wherefrom furthermore hereto members of the aforementioned UNIVERSAL POPULACE™ legal emergency planning definitive discrete integer numeric metric system figure tabulating natural disaster fund elective propagations; wherefrom moreover hereto members of the aforementioned UNIVERSAL POPULACE™ legal emergency planning definitive discrete integer numeric metric system figure tabulating disaster relief elective propagations; wherefrom furthermore hereto members of the aforementioned UNIVERSAL POPULACE™ legal emergency planning definitive discrete integer numeric metric system figure tabulating insurance fund elective propagations; wherefrom moreover hereto members of the aforementioned UNIVERSAL POPULACE™ legal emergency planning definitive discrete integer numeric metric system figure tabulating insurance relief elective propagations; wherefrom furthermore hereto members of the aforementioned UNIVERSAL POPULACE™ legal emergency planning definitive discrete integer numeric metric system figure tabulating assurance fund elective propagations; wherefrom moreover hereto members of the aforementioned UNIVERSAL POPULACE™ legal emergency planning definitive discrete integer numeric metric system figure tabulating assurance relief elective propagations; wherefrom furthermore hereto members of the aforementioned UNIVERSAL POPULACE™ legal retirement planning definitive discrete integer numeric metric system figure tabulating social entitlement fund elective propagations; wherefrom moreover hereto members of the aforementioned UNIVERSAL POPULACE™ legal retirement planning definitive discrete integer numeric metric system figure tabulating social entitlement security relief elective propagations; wherefrom furthermore hereto members of the aforementioned UNIVERSAL POPULACE™ legal domestic and/or expatriate dominion certified domain passport recording definitive discrete integer numeric metric system figure tabulating elective propagations; wherefrom moreover hereto members of the aforementioned UNIVERSAL POPULACE™ legal migratory census tracking definitive discrete integer numeric metric system figure tabulating elective propagations; wherefrom furthermore hereto members of the aforementioned UNIVERSAL POPULACE™ legal daily, weekly, semi-monthly, monthly, semi-annual, trimester, annual, seasonal, cyclical, frictional and/or fractional employment tracking definitive discrete integer numeric metric system figure tabulating elective propagations; wherefrom moreover hereto members of the aforementioned UNIVERSAL POPULACE™ legal voter registration definitive discrete integer numeric metric system figure tabulating elective propagations; wherefrom furthermore hereto members of the aforementioned UNIVERSAL POPULACE™ legal voting ballot casting definitive discrete integer numeric metric system figure tabulating elective propagations; wherefrom furthermore hereto members of the aforementioned UNIVERSAL POPULACE™ legal voter reregistration definitive discrete integer numeric metric system figure tabulating elective propagations; wherefrom moreover hereto members of the aforementioned UNIVERSAL POPULACE™ legal voting ballot definitive discrete integer numeric metric system figure tabulating elective propagations; wherefrom moreover hereto members of the aforementioned UNIVERSAL POPULACE™ legal absentee voting ballot definitive discrete integer numeric metric system figure tabulating elective propagations; wherefrom moreover hereto members of the aforementioned UNIVERSAL POPULACE™ legal proxy voting ballot definitive discrete integer numeric metric system figure tabulating elective propagations; wherefrom moroever hereto members of the aforementioned UNIVERSAL POPULACE™ legal occupancy insurance fund definitive discrete integer numeric metric system figure tabulating disaster protection elective propagations; wherefrom moreover hereto members of the aforementioned UNIVERSAL POPULACE™ legal occupancy protection definitive discrete integer numeric metric system figure tabulating disaster relief elective propagations; wherefrom furthermore hereto members of the aforementioned UNIVERSAL POPULACE™ legal motor vehicle licensing definitive discrete integer numeric metric system figure tabulating elective propagations; wherefrom moreover hereto members of the aforementioned UNIVERSAL POPULACE™ legal motor vehicle relicensing definitive discrete integer numeric metric system figure tabulating elective propagations; wherefrom furthermore hereto members of the aforementioned UNIVERSAL POPULACE™ legal motor vehicle reregistration definitive discrete integer numeric metric system figure tabulating elective propagations; wherefrom moreover hereto members of the aforementioned UNIVERSAL POPULACE™ legal motor vehicle insurance protection definitive discrete integer numeric metric system figure tabulating elective propagations; wherefrom furthermore hereto members of the aforementioned UNIVERSAL POPULACE™ legal motor vehicle reassurance protection definitive discrete integer numeric metric system figure tabulating elective propagations; wherefrom moroever hereto members of the aforementioned UNIVERSAL POPULACE™ legal motor vehicle emission inspection definitive discrete integer numeric metric system figure tabulating elective propagations; wherefrom furthermore hereto members of the aforementioned UNIVERSAL POPULACE™ legal motor vehicle emission reinspection definitive discrete integer numeric metric system figure tabulating elective propagations; wherefrom moreover hereto members of the aforementioned UNIVERSAL POPULACE™ legal motor vehicle assurance protection definitive discrete integer numeric metric system figure tabulating elective propagations; wherefrom furthermore hereto members of the aforementioned UNIVERSAL POPULACE™ legal motor vehicle reassurance protection definitive discrete integer numeric metric system figure tabulating elective propagations; wherefrom moreover hereto members of the aforementioned UNIVERSAL POPULACE™ legal motor article assurance protection definitive discrete integer numeric metric system figure tabulating elective propagations; wherefrom furthermore hereto members of the aforementioned UNIVERSAL POPULACE™ legal motor article reassurance protection definitive discrete integer numeric metric system figure tabulating elective propagations; wherefrom moreover hereto members of the aforementioned UNIVERSAL POPULACE™ legal procedural recording definitive discrete integer numeric metric system figure tabulating elective propagations; wherefrom furthermore hereto members of the aforementioned UNIVERSAL POPULACE™ legal civil recording definitive discrete integer numeric metric system figure tabulating elective propagations; wherefrom moreover hereto members of the aforementioned UNIVERSAL POPULACE™ legal real-estate zoning definitive discrete integer numeric metric system figure tabulating elective propagations; wherefrom furthermore hereto members of the aforementioned UNIVERSAL POPULACE™ legal background criminal recording definitive discrete integer numeric metric system figure tabulating elective propagations; wherefrom moreover hereto members of the aforementioned UNEERSAL POPULACE™ legal public recording definitive discrete integer numeric metric system figure tabulating elective propagations; wherefrom furthermore hereto members of the aforementioned UNIVERSAL POPULACE™ legal bankruptcy seizure, disolvement, distribution and/or transport recording definitive discrete integer numeric metric system figure tabulating elective propagations; wherefrom moreover hereto members of the aforementioned UNIVERSAL POPULACE™ legal credit reporting definitive discrete integer numeric metric system figure tabulating elective propagations; wherefrom furthermore hereto members of the aforementioned UNIVERSAL POPULACE™ legal background check reporting definitive discrete integer numeric metric system figure tabulating elective propagations; wherefrom moreover hereto members of the aforementioned UNIVERSAL POPULACE™ legal disertating, counseling, advising, guiding, recommending, representing, courts, trials, appeals, arbitrations, mediations, council, forum, diplomatics, summits, diplomacies, agreements, accord, partnership, alliance, joint venture, incorporations, mergers, treaties, treaty, session, consortium, bicameral, committee, cabinet, commission, convention, declaration, doctrine, constitution, amendment, patent, congressional, legislature, executive and/or judicial recording definitive discrete integer numeric metric system figure tabulating elective propagations; wherefrom furthermore hereto members of the aforementioned UNIVERSAL POPULACE™ legal appropriation recording definitive discrete integer numeric metric system figure tabulating elective propagations; wherefrom moreover hereto personal, members of the aforementioned UNIVERSAL POPULACE™ legal requisition recording definitive discrete integer numeric metric system figure tabulating elective propagations; wherefrom furthermore hereto members of the aforementioned UNIVERSAL POPULACE™ legal retrenchment recording definitive discrete integer numeric metric system figure elective propagations; wherefrom moreover hereto members of the aforementioned UNIVERSAL POPULACE™ legal asset seizure, clearance, metric conversion, assignment, distribution and/or transport recording definitive discrete integer numeric metric system figure elective propagations; wherefrom furthermore hereto members of the aforementioned UNIVERSAL POPULACE™ legal residual equity seizure, clearance, metric conversion, assignment, distribution and/or transport recording definitive discrete integer numeric metric system figure elective propagations; and wherefrom moreover hereto members of the aforementioned UNIVERSAL POPULACE™ legal liability seizure, clearance, metric conversion, assignment, distribution and/or transport recording definitive discrete integer numeric metric system figure elective propagations. Wherefrom, every and all aforementioned inherently entail, encompass, comprise, involve, impact and/or effect every and all obscurant, irresponsible, feculent, irrational, feckless, disrespectful, mendacious, ignorant, malicious, condescending, untruthful, insolent, inefficient, incognizant, ineffective, fragmenting, unlettered, unpolished, presumptuous, portentous, pretentious, fruitless, disparate, antiquated, archaic, ancient history and superannuated so-called real-time processing and/or reprocessing of data and/or information receiver inclusive of, without limitation, every and all filing of periodic, interim and annual Personal Financial Statements (PFS) inclusive of certified payments on income, capital gains and every and all comprehensively suitably, generally pertient and broadly useful herewith undeniably, logically, scientifically and intuitively necessarily integrated, critically important and increasing integral hereto members of the aforementioned UNIVERSAL POPULACE™ legal licenses, taxes, rates, assessments, charges, fees, tariffs, sur-charges inclusive of every and all pricing, costing, operating, franchising, leasing, purchasing, financing and/or commissioning proposed, stipulated, substantiated, justified, verified, traversed, enacted, levied, imposed, rated, assessed, certified, propagating and subsequent promulgation respectively via legitimate and instrinsically certified hereto members of the aforementioned UNIVERSAL POPULACE™ legal instrinsic and integral entities, beings, elements, components, factors, constituents and ingredients within, throughout and transcending filing and payment of every and all obscurant, irresponsible, feculent, irrational, feckless, disrespectful, mendacious, ignorant, malicious, condescending, untruthful, insolent, inefficient, incognizant, ineffective, fragmenting, unlettered, unpolished, presumptuous, portentous, pretentious, fruitless, disparate, antiquated, archaic, ancient history and superannuated so-called U.S. Department of Treasury (so-called U.S. Treasury) superannuated internal revenue service agency generator scheduled and/or unscheduled Forms and Schedules inclusive of so-called U.S. Treasury Form 1040 in connection with applicable unitemized and basic so-called U.S. Treasury Schedule A, B, and D and/or so-called U.S. Treasury Form 1040-EZ from members of the aforementioned UNIVERSAL POPULACE™, inclusive of the more itemized and complex so-called U.S. Treasury Form 1040 in connection with a so-called U.S. Treasury Schedule C, wherefrom further hereto invoked within aforementioned UCMOST™ information technology is comprehensively suitable, generally pertinent and broadly useful to intrinsically certified filing every and all interim so-called U.S. Securities and Exchange Commission (so-called U.S. SEC) processing heretofore via the anciet history presently licensed Electronic Data Gathering and Automated Retrieval (EDGAR) System wherefrom hereto evincing interim so-called U.S. Form 8-K with a standard fifteen-day time-lagged inabsentia, hardship, inanition, skidding, stalling, hesitant, holding, refusing and restraining unscheduled aforementioned PUBLIC FINANCIALS™ statements, interim so-called U.S. SEC Form 10-Q with a standard forty-five time-lagged inabsentia, hardship, inanition, skidding, stalling, hesitant, holding, refusing and restraining aforementioned PUBLIC FINANCIALS™ statements, interim General Purpose Financial Statements (GPFS) aforementioned PUBLIC FINANCIALS™ statements, interim so-called U.S. SEC Form 10-QSB aforementioned PUBLIC FINANCIALS™ statements from small business registrants, interim so-called U.S. SEC Form SC-13G aforementioned PUBLIC FINANCIALS™ statements filings from beneficial owners, interim so-called U.S. SEC Form SC-13G/A aforementioned PUBLIC FTNANCIALS™ statements amended filings from beneficial owners, interim so-called U.S. SEC Form DEF 13-F aforementioned PUBLIC FINANCIALS™ statements comprehensively suitable, generally pertinent and broadly useful to reporting on aforementioned PUBLIC FINANCIALS™ instruments from banking, securities, insurance related public organizations inlcusive of, without limitation, whichever furthermore transactional exchange advisers, transactional exchange companies, foundations, endownments and pension funds wherefrom hereto terminological denominatively part and form members of the aforementioned UNIVERSAL POPULACE™, interim so-called U.S. SEC Form DEF 14-A aforementioned PUBLIC FINANCIALS™ statements comprehensively suitable, generally pertinent and broadly useful to proxy voting from members of the aforementioned UNIVERSAL POPULACE™, interim so-called U.S. SEC Form 497 aforementioned PUBLIC FINANCIALS™ statements comprehensively suitable, generally pertinent and broadly useful to initial filing registration prospectus from transactional exchange company related members of the aforementioned UNIVERSAL POPULACE™, interim so-called U.S. SEC Form 24F-2NT aforementioned PUBLIC FINANCIALS™ statements of registration aforementioned PUBLIC FINANCIALS™ instruments from transactional exchange company related members of the aforementioned UNIVERSAL POPULACE™, interim so-called U.S. SEC Form N-30D aforementioned PUBLIC FINANCIALS™ statements comprehensively suitable, generally pertinent and broadly useful to semi-annual reporting from transactional exchange company related members of the aforementioned UNIVERSAL POPULACE™, initial so-called U.S. SEC Form 3 aforementioned PUBLIC FINANCIALS™ statements comprehensively suitable, generally pertinent and broadly useful to initial filing of directors, officers and persons or public organizations owning more than 10% of any class from members of the aforementioned UNIVERSAL POPULACE™, interim so-called U.S. SEC Form 4 aforementioned PUBLIC FINANCIALS™ statements comprehensively suitable, generally pertinent and broadly useful to filing intention of disolvement of positions from directors, officers and persons and/or public organizations owning more than 10% aforementioned PUBLIC FINANCIALS™ instruments of any class from members of the aforementioned UNIVERSAL POPULACE™, wherefrom further hereto annual so-called U.S. SEC Form 10-K with a standard ninety-day time-lagged inabsentia, hardship, inanition, skidding, stalling, hesitant, holding, refusing and restraining aforementioned PUBLIC FINANCIALS™ statements, annual Comprehensive Annual Financial Reports (CAFR) aforementioned PUBLIC FINANCIALS™ statements, annual so-called U.S. SEC Form 20-F aforementioned PUBLIC FINANCIALS™ statements and/or annual so-called U.S. SEC Form 5 aforementioned PUBLIC FINANCIALS™ statements respectively from domestic, foreign registrants and/or directors, officers and persons and/or public organizations owning more than 10% aforementioned PUBLIC FINANCIALS™ instruments of any class from members of the aforementioned UNIVERSAL POPULACE™ in combination with the aforementioned PUBLIC FINANCIALS™ instruments to effectuate management decisions regarding the operating performance, transactional exchange and financial profitability members of the aforementioned UNIVERSAL POPULACE™, wherefrom hereto evidently deriving, inducing and invoking further terminological denominative of every and all aforementioned PUBLIC FINANCIALS™ instruments as comprehensively suitable, generally pertinent and broadly useful via streamlined, alternating scale, inseparable, seamless and natural wrapping, interlacing, coiling, coupling, combining and interlocking within every and all aforementioned PUBLIC FINANCIALS™ statements traversing inclusive of, without limitation, every and all other industries and sectors in a single holistically econometric marketplace environment beyond the following specified multifaceted industries and multidimensional sectors entailing, encompassing, comprising, involving, impacting and/or effecting banking, securities and insurance, wherefrom hereto it is clearly an undeniable and evidentiary findings of fact, documented reference, logical scientific deduction and intuitive analytical reasoning that every and all interim and so-called periodic aforementioned PUBLIC FINANCIALS™ statements from every and all members of the aforementioned UNIVERSAL POPULACE™ hereafter sporadically and randomly independently audited for the benefit of establishing an effective, functional and interlocking aforementioned efficient UNIVERSAL CAPITAL MARKET™, wherefrom further hereto invoking aforementioned UCMOST™ information technology is comprehensively suitable, generally pertinent and broadly useful as it entails, encompases, comprises, involves, impacts and effects knowledge of techniques, processes, aspects, topics, issues, matters, elements, components, functions, procedures, designs, systems, devices, forms, factors, ways, parts, segments and methods of combining aforementioned via originating automatizing real-time transmission propagating transporting transmuting partible beta particle beam gliding transponder converting receiver conduit aforementioned UCMOST™ real-time processing and/or reprocessing of data and/or information transmission whichever whenever wherefrom entailing, encompassing, comprising, involving, impacting and/or effecting every and all manufacture, formatting, production and distribution wherefrom whichever every and all aforementioned PUBLIC FINANCIALS™ instruments in connection with every and all aforementioned PUBLIC FINANCIALS™ statements necessarly entail, encompass, comprise, involve, impact and/or effect every and all propagating transactional exchange initiatives, schemes, ocurrences, happenings, interactions, processes, methods, practices, movements, proceedings, messaging, presentations, notifications, filings, submissions, records, activities, actions, events, endeavors, tasks and affairs whether effectuated, without limitation, within, throughout and transcending every and all stock, bond, option, future, forward, swap, commodity, originating, derivative and/or synthetic derivative oriented antiquated, archaic, ancient history and superannuated heretofore licensed and/or non-certified market exchanges anytime, anyplace and anywhere within a single holistically econometric marketplace environment of which every and all necessarily, undeniably, logically, scientifically and intuitively entails, encompasses, comprises, involves, impacts and effects every and all whichever of the distincitvely separate and traditionally exclusive specialty areas of general private and public accounting, general private and public transport reconciling, general private and public independent auditing and general private and public reporting inclusive of every and all quotation, matching, clearance, settlement and exchange of general private and public insurance, general private and public so-called risk financing, general private and public credit, general private and public cash management, general private and public investment banking and general private and public aforementioned PUBLIC FINANCIALS™ instruments heretofore entailing, encompassing, comprising, involving, impacting and/or effecting every and all classifications, categorizations and/or stratifications of hereto members of the aforementioned UNIVERSAL POPULACE™ legal operations irrespective of whether whichever heretofore distinctively separate and traditionally exclusive aforementioned PUBLIC FINANCIALS™ instruments and whichever heretofore distinctively separate and traditionally exclusive aforementioned PUBLIC FINANCIALS™ statements are transpired and/or effectuated via every and all antiquated, archaic, ancient history and superannuated identifying, organizating, indexing, cataloging, categorizing and/or processing to inefficiently derive collections of literary, melodius, aesthetic and artistic works via audio, video, voice, visual and imaging media entailing, encompassing, comprising, involving, impacting and/or effecting, without limitation, every and all antiquated, archaic, ancient history and superannuated market exchanges residing and/or operating within every and all national sovereign borders of every and all of the industrialized, developed and developing free-market commerce and trade bloc economies within, throughout and transcending a single holistically econometric marketplace environment inclusive of, without limitation, every and all of the following mental, audio, visual, taste, touch and smell oriented apprehending and cognizably appearing, recognizing, identifying, acknowledging, associating, filtering, sorting, organizing, conceptualizing, understanding and comprehending representational abstract conceptual aids inclusive of, without limitation, every and all: word; character; denumerable; cast, label; category; acronym; trace; notice; letter; mailer; update; release; propoganda; newsletter; hard-cover book; soft-cover paper-back book; magazine; article; publication; periodical; magazine; serial; trace; editorial; newspaper; flier; card; circular; symbol; theme; directive; leaf-letter book; text-book; hypothesis; theory; manuscript; disertation; pamphlet; memorandum, promotion; silkier; announcement; pronouncement; prop; propitious; propel; solicit; advance; tempt; beckon; brochure; report; list; title; art; lyrics; songs; description; methodical; content; material; documentation; compilation; illustration; classification; catalog; manual; non-book; movie; video game; program; performances; enumeration; story; annotate; pictorial; photograph; print; paint; ink; oil; pastel; pigment; pen; pencil; dye; chalk; chart; graph; presentation; graphic; imaging; figuration; object; prop; antique; woodwork; craftwork; artwork; artifacts; array; audio; visual; voice; text; numerical; keying; pulsing; auctioning; laser; morse code; continental code; brailling; dialogue; discourse; literature; theatrical; represent; narrate; trace; reportage; play script; play bill; play write; comment; partial; heuristic; inference; exposition; announce; monologue; epilogue; speech; commentary; nominative; numeration; digits; charactery; denumerable; charade; characterization; reference; numeric; numismatic; fiction; nuptial; non-fiction; prose; allegory; anagram; black board; drawing board; computer aided designing; clip board; story board; back board; background; time exposure; tincture; tinging; distinguishing; tinsel; tinting; tinkling; tangible property; service mark; trademark; symbol; emblem; logo; flag; great seal; copyright; intangibles; proof; galley proof; press; copy; post; display; duplication; utilization; echo; reverberation; plea; mendicant; response; report; common talk; message; rumor; static; gossip; summation; relate; feature; presentation; append; fixture; etch; mount; embed; repugn; repulse; reprove; reprimand whether concretizing, actualized, materialized and/or traversed manually, artistically, theatrically, literarily, melodiously and/or gramatically initiated, enacted, performed, propagating and/or promulgated via hereto members of the aforementioned UNIVERSAL POPULACE™ initiatives, schemes, ocurrences, happenings, interactions, processes, methods, practices, movements, proceedings, messaging, presentations, notifications, filings, submissions, records, activities, actions, events, endeavors, tasks and affairs hereto anywhere, anyplace and anytime via every and all standalone, networked, portable, desktop, laptop, tablet, transmit article, and/or fixtured compressible, compact and/or disparate electrial, battery, radio, television, telephony, telegraphy, typography, photographic and/or solar conduit read and write and/or write-only artifical atmospheric ground wave and/or aeronautical airway casing dish, transmitter, receiver, cassettee, cartridge, pan and/or container inclusive of, without limitation, all the following; microdisk; microfilm; microfiche; microplate; magnetic film; magnetic reel; hard diskette; floppy diskette; magnetic tape drive; magnetic film diskette; magnetic microfilm disk; magnetic microplate disk; paper tape cast; file folder; file drawer; file cabinet; display calculator; cash register; display cash register; display computing article; file storage computing article; teletype interface computing article; teleprompt interface computing article; articled hard core computing disk drive; articled mainframe computing disk drive; articled server computing disk drive; articled network transport routing computing disk drive; articled magnetic reel computing disk drive; articled personal hard computing disk drive; articled desktop hard computing disk drive; articled personal laptop computing disk drive; articled personal tablet computing disk drive; articled personal telephony computing disk drive; articled video game computing disk; articled digital video computing disk; wherefrom whichsoever, every and all whenever and wheresoever entailing, encompassing, comprising, involving, impacting and/or effecting manual, passive and/or below specified automatizing real-time transmission propagating transporting transmuting partible beta particle beam gliding transponder converting receiver conduit real-time processing and/or reprocessing of data and/or information of whichever whenever and whereever entailing, encompassing, comprising, involving, impacting and/or effecting manual, passive and/or automatizing real-time transmission propagating transporting transmuting partible beta particle beam gliding transponder converting receiver conduit aforementioned UCMOST™ real-time processing and/or reprocessing; wherefrom applicable herewith further entailing, encompassing, comprising, involving, impacting and/or effecting reasearch, development, planning, building, construction, startup, operations, management, upkeep and/or dissolving applicable within every and all of the comprehensively suitable, generally pertient and broadly useful albeit extremely limited area classifictions and/or categorizations inclusive of, without limitation, every and all of the following: members of the aforementioned UNIVERSAL POPULACE™ agriculture; members of the aforementioned UNIVERSAL POPULACE™ construction; food members of the aforementioned UNIVERSAL POPULACE™ foods; members of the aforementioned UNIVERSAL POPULACE™ beverages; members of the aforementioned UNIVERSAL POPULACE™ lumber; members of the aforementioned UNIVERSAL POPULACE™ mining; members of the aforementioned UNIVERSAL POPULACE™ natural resources; members of the aforementioned UNIVERSAL POPULACE™ textiles; members of the aforementioned UNIVERSAL POPULACE™ primary metals; members of the aforementioned UNIVERSAL POPULACE™ fabrics; members of the aforementioned UNIVERSAL POPULACE™ machinery; members of the aforementioned UNIVERSAL POPULACE™ computing; members of the aforementioned UNIVERSAL POPULACE™ devices; members of the aforementioned UNIVERSAL POPULACE™ electronics; members of the aforementioned UNIVERSAL POPULACE™ equipment; members of the aforementioned UNIVERSAL POPULACE™ transportation; members of the aforementioned UNIVERSAL POPULACE™ manufacturing; members of the aforementioned UNIVERSAL POPULACE™ instruments; members of the aforementioned UNIVERSAL POPULACE™ railroad; members of the aforementioned UNIVERSAL POPULACE™ transit; members of the aforementioned UNIVERSAL POPULACE™ air, land and water conduits; members of the aforementioned UNIVERSAL POPULACE™ utilities; members of the aforementioned UNIVERSAL POPULACE™ wholesale; members of the aforementioned UNIVERSAL POPULACE™ retail merchandising; members of the aforementioned UNIVERSALPOPULACE™ treasuring; members of the aforementioned UNIVERSAL POPULACE™ accounting; members of the aforementioned UNIVERSAL POPULACE™ communicating; members of the aforementioned UNIVERSAL POPULACE™ transporting; members of the aforementioned UNIVERSAL POPULACE™ energizing; members of the aforementioned UNIVERSAL POPULACE™ fueling; members of the aforementioned UNIVERSAL POPULACE™ broadcasting; members of the aforementioned UNIVERSAL POPULACE™ distributing; members of the aforementioned UNIVERSAL POPULACE™ financing; members of the aforementioned UNIVERSAL POPULACE™ insurance; members of the aforementioned UNIVERSAL POPULACE™ real estate; members of the aforementioned UNIVERSAL POPULACE™ public services; members of the aforementioned UNIVERSAL POPULACE™ public administration; members of the aforementioned UNIVERSAL POPULACE™ health administration; members of the aforementioned UNIVERSAL POPULACE™ legal administration; members of the aforementioned UNIVERSAL POPULACE™ heretofore non-classifiable variables; wherefrom every and all aforementioned goods, products, services and supplies inclusive of every and all necessarily integrated, critically important and increasingly integral aforementioned PUBLIC FINANICALS instruments exchanges whether or not registered, listed and/or licensed market exchanges heretofore as physical, electronic, telephony, virtual and/or webpage data transport conduits transmitting to/from converting receivers realizing antiquated, archaic, ancient history and superannuated identifying, organizating, cataloging, indexing, categorizing and/or processing to ensure concretizing of methodological pooling and batch transmission to/from converting reciever traverse conduit data transport processing evincing further, without limitation, every and all of the following: antiquated, archaic, ancient history and superannuated physical, electronic, telephony, facsimile, virtual, dumb terminal and/or webpage veiled, hesitant, delayed, holding, time-lagged, restraining, raptorial and utterly inefficient instrument quotation, matching, clearance, settlement and exchange processing entailing, encompassing, comprising, involving, impacting and/or effecting pestilent credit card processing, presumptous card check processing, portentous check draft processing, detrimental sparing electronic funds transport processing, debilitating time-lagged financial market data processing, importune information, pestiferous news, chalandrical commercials, bombarding advertisements, boisterous silkiers, imprudent propagations, harassing notices, imposing messages, demoralizing collections; uproarious mailings, speiling articles, spectacle fliers, impetuous circulars, insinuating letters, condescending directives, unfruitful pretending; glittering props, propositional designs, unreserved uploading, provacative displaying, unnerving postings, subsidizing tactics, unjustifiable speculations, sporadic searching, unauthorized downloading, superfluous dialoguing, delayed streaming, illegal spamming, defensive services, illegal slamming, spiteful defamations, illegal dumping, deferred accountability, illegal gouging, harmful discounting, imprudent allowing, submissive rebating, intoxicative coupon refunding, inured inducing, guise motivating, incentive returning, insolent discourse, damaging converse, veiled prying, guile peeping, derogatory hacking, abstruse linking, deceptive twisting, obstructive coiling, feeler convoluting, referral coupling, insistent mixing, enthralled intertwining, restrictive interfacing, selective releasing, spinning updates, harassing reporting, imprinting announcements, hesitant pronouncements, pestering promotions, pressing tourism, spicing sponsoring, defamatory propitiating, portentuous soliciting, voracious contracting, subliminal propaganda, specious traces, fragmenting editorials, pretending newsletters, sponsored newspapers, presuming periodicals, oppressing publications, bolstering magazines inclusive of every and all such national and transnational network broadcasting, distributing and/or syndicating transmission, rebroadcasting, redistributing and/or resyndicating transmission signal addressing stations; wherefrom whichever entailing, encompassing, comprising, involving, impacting and/or effecting every and all, without limitation, of the following general classifications, categorizations and/or stratifications of sectors and industries within, throughout and transcending the national sovereign borders of every and all of the industrialized, developed, developing free-market and trade bloc economies of a single holistically econometric marketplace environment: aforementioned PUBLIC FINANCIALS™ agriculture, aforementioned PUBLIC FINANCIALS™ construction; food aforementioned PUBLIC PINANCIALS™ foods; aforementioned PUBLIC FINANCIALS™ beverages; aforementioned PUBLIC FINANCIALS™ lumber; aforementioned PUBLIC FINANCIALS™ mining; aforementioned PUBLIC FINANCIALS™ natural resources; aforementioned PUBLIC FINANCIALS™ textiles; aforementioned PUBLIC FINANCIALS™ primary metals; aforementioned PUBLIC FINANCIALS™ fabrics aforementioned PUBLIC FINANCIALS™ machinery; aforementioned PUBLIC FINANCIALS™ computing; aforementioned PUBLIC FINANCIALS™ devices; aforementioned PUBLIC FINANCIALS™ electronics; aforementioned PUBLIC FINANCIALS™ equipment; aforementioned PUBLIC FINANCIALS™ transportation; aforementioned PUBLIC FINANCIALS™ manufacturing; aforementioned PUBLIC FINANCIALS™ instruments; aforementioned PUBLIC FINANCIALS™ railroad; aforementioned PUBLIC FINANCIALS™ transit; aforementioned PUBLIC FINANCIALS™ atmospheric and/or galatic outer space air, land and water conduits; aforementioned PUBLIC FINANCIALS™ atmospheric and/or galatic outer space air, land and water offensive and/or defensive weaponry; aforementioned PUBLIC FINANCIALS™ utilities; aforementioned PUBLIC FINANCIALS™ wholesale; aforementioned PUBLIC FINANCIALS™ retail merchandising; aforementioned PUBLIC FINANCIALS™ treasuring; aforementioned PUBLIC FINANCIALS™ accounting; aforementioned PUBLIC FINANCIALS™ communicating; aforementioned PUBLIC FINANCIALS™ transporting; aforementioned PUBLIC FINANCIALS™ energizing; aforementioned PUBLIC FINANCIALS™ fueling; aforementioned PUBLIC FINANCIALS™ broadcasting; members of the aforementioned UNIVERSAL POPULACE™ distributing; aforementioned PUBLIC FINANCIALS™ financing; aforementioned PUBLIC FINANCIALS™ insurance; aforementioned PUBLIC FINANCIALS™ real estate; aforementioned PUBLIC FINANCIALS™ public services; aforementioned PUBLIC FINANCIALS™ public administration; aforementioned PUBLIC FINANCIALS™ health administration, aforementioned PUBLIC FINANCIALS™ legal administration; aforementioned PUBLIC FINANCIALS™ heretofore non-classifiable variables. Wherefrom it is an undeniable and evidentiary findings of fact, documented reference, logical scientific deduction and intutive analytical reasoning that every and all of the aforementiond so-called classifications, categorizations and/or stratifications of aforementioned PUBLIC FINANCIALS™ organizations engage in research, design, production, testing, manufacture, development, promotion, distribution and/or syndication generating so-called leads leveraged into so-called referrals which are inefficiently thereupon but without gurantees whatsoever turned into so-called contacts further potentially leading to so-called connections which may or may not facilitate entry into so-called networking circles, whereupon potentially greasing so-called appointments to enable on-site person-to-person interface thereunto creating further inefficient dealy which eventually may lead to a potential distribution whether contracted or otherwise. Wherefrom this cycle propagates eventual distribution and utility of every and all so-calleed products, goods, services and supplies via one form or another however one with so-called experience in any one particular sector or industry would find beneficial to their cause to obfuscate via every and all terminological denominative conveyance whichever heretofore obfuscating so-called disciplinary fields of involving traditionally separate and distinctively exclusive specialty areas to their own so-called sectors and industries within a single holistically econometric marketplace environment, and further it is an undeniable and evidentiary findings of fact, documented reference, logical scientific deduction and intuitive analytical reasoning that every and all requisition, acquisition, distribution, transfer, leasing, purchasing and/or outright sale of products, goods, services and supplies so-called products, goods, services and supplies are necessarily, undeniably, logically, scientifically and intuitively exclusively consumed, leveraged, harnessed, ingested and/or utilized by individual members of the aforementioned UNIVERSAL POPULACE™ whichever directly and/or indirectly ultimately attributable to one or another individual, but whereupon all of whom are in one form or another, without any regard to limits, classifications, categorizations and/or stratifications related to socioeconomic background entailing, encompassing, comprising, involving, impacting and/or effecting, without limitation, birth right origin, heirship and/or access to wealth, property and/or currency or the lack thereof, wherefrom furthermore ensuring truth, justice and equal opportunity for all without discrimination to race, color, ethnicity, age, gender, languages, employment, legal status, national origin, religionn, or mential and/or physical disability Moroever, it is an undeniable and evidentiary findings of fact, documented reference, logical scientific deduction and intuitive analytical reasoning that every and all inefficient, ineffective, dysfunctional and fragmented aforementioned general and/or formulated classifictions, categorizations and/or stratifications of aforementioned PUBLIC FINANCIALS™ organizations heretofore and hereafter necessarily, undeniably, logically, scientifically and intuitively employ the greatest majority of the individual whom are either directly and/or indirectly impacte and/or effected from propagating, promulgating and proclaiming the products, goods, services and supplies produced, promoted and/or distributed via the antiquated, archaic, ancient history and superannuated so-called supply chains of these herein general and/or formulated aforementioned PUBLIC FINANCIALS™ organizations among the national sovereign industrialized, developed and developing free-market commerce and trade bloc economies within, throughout and transcending a single holistically econometric marketplace environment. Furthermore, wherefrom every and all aforementioned PUBLIIC FINANCIALS™ orgnizations heretofore leverage, harness and utilize every and all of the aforementioned ancient history fragmented market inefficiencies to produce, promote and/or distribute their so-called products, goods, services and supplies via every and all of the communications seamlessly incorporating every and all of the conceptual aids. Wherefrom above aforementioned UCMOST™ information technology is a novel, unobvious, unknown, unforeseen, unprecedented, epoch, paper-less, ease of use, fruitful and opportune panacean cutting-edge breakthrough utility engineering and groundbreaking technological architectural design innovation which is herewith proofed apprehension of a self-contained, fault-tolerant, anonymous, independent, autonomous, impartial, apolitical, streamlined, alternating scale and inseparable proprietary multiport revolving chambered hunting metallic track encasing hermetic cast casing constrained new software commutative rhombus robotizing real-time microprocessor engineering machine language unicore operating system software computing block whose universal dominion domain outline is comprehensively suitable, generally pertinent and broadly useful wherefrom hereto entailing, encompassing, comprising, involving, impacting and/or effecting automatizing real-time holistically steady state synchronized ubiquitous continuum sub-loculated cyclical commutative rhombus robotizing real-time operating microprocessor engine computing system logic instructions propagating, promulgating and proclaiming across-the-board traversal of breakthrough technological and groundbreaking innovative developments and advancements within multifaceted and multidimensional microcosmic techniques, designs, systems, routines, devices, manners, modes, fashions, forms, formats, factors, objects, parts, segments, elements, components, constituents, ingredients, processes, methods and combinations wherefrom hereto to whichever and whensonever, anytime, anyplace and anytime, hereafter naturally evincing and requisiting every and all, without limitation, conceived, created, engineered, designed, development, and hereto concretizing via consummate melioristic logical positivism devotional praxis and timely constructive reduction to practice of innovatively novel, unknown, unforeseen and unprecedented real-time processing of data and/or information receiver via continuous uptime steady state ubiquitous real-time streaming automatizing real-time transmission propagating transporting transmuting partible beta particle beam gliding transponder converting receiver conduit real-time processing of data retrieval and/or information processing inclusive of, without limitation, every and all exclusively prudent and requisitioned comprehensively suitable, generally pertinent and broadly useful follow-up and follow-through; whereas, UCMOST™ information technologies are comprehensively suitable, generally pertinent and broadly useful to supplant every and all antiquated, archaic, ancient history and superannuated preconceived notions of the following: retrieving; converting; formatting; processing; storing; gathering; compiling; tabulating; casting; calculating; preparing; editing; tracing; verifying; submitting; confirming; validating; booking; classifying; categorizing; adjusting; altering; revising; changing; billing; collecting; producing; composing; conducting; proofing; filtering; pressing; publishing; cataloging; indexing; scripting; locating; shooting; running; releasing; posting; compressing; presenting; releasing; playing; displaying; projecting; broadcasting; syndicating; whereas, moreover inclusive of, without limitation, supplanting every and all antiquated, archaic, ancient history and superannuated preconceived notions of the following: reretrieval; retransport; reconversion; reformatting; reprocessing; resaving; restoring; reidentifying; regathering; resorting; reorganizing; recompiling; retabulating; recasting; recalculating; repreparing; reediting; retracing; reverifying; resubmitting; reconfirming; revalidating; rebooking; reclassifying; recategorizing; readjusting; realtering; rerevising; rechanging; recharging; rebilling; recollecting; reproducing; recomposing; reconducting; reproofing; refiltering; repressing; republishing; recataloging; reindexing; rescripting; relocating; reshooting; rerunning; rereleasing; reposting; recompressing; representing; rereleasing; replaying; redisplaying; reprojecting; rebroadcasting; resyndicating; wherefrom, hereto collectively innate conception, terminological conveyance, indivisible rubrical, syntactic oralformulaic, systematic arrangement, artistic construct, melodious lyrics, denominative literateness and thereat proprietary multiport revolving chambered hunting metallic track encasing hermetic new software lock up cast casing constrained real-time microprocessor engineering machine language unicore operating system software computing block keyhole combinational code heretofore and hereafter apprehends UCMOST™ real-time processing and/or reprocessing; proprietary trademark and service mark is exclusive proprietary intellectual property belonging exclusively and unequivocally to Juan Carlos Castro. Wherefrom hereto aforementioned UCMOST™ real-time processing and/or reprocessing leveraging and harnessing every and all continuous uptime steady state ubiquitous real-time streaming automatizing real-time transmission propagating transporting transmuting partible beta particle beam gliding transponder converting receiver conduit articles, apparatuses and/or megastructres whereas hereto discovered to be comprehensively useful, generally pertinent and broadly useful anywhere, anytime and anyplace which propagate entailing, encompassing, comprising, involving, impacting and/or effecting streamlined, alternating scale, inseparable, seamless and natural wrapping, interlacing, coiling, coupling, combining and interlocking proprietary multiport revolving chambered hunting metallic track encasing hermetic cast casing constrained new end-user graphical human interface syntactic synthesis real-time software programs block, proprietary multiport revolving chambered hunting metallic track encasing hermetic cast casing constrained new algebraic problem-solving application syntactic synthesis real-time software programs block, proprietary multiport revolving chambered hunting metallic track encasing hermetic cast casing constrained new robotizing tracking meter systems syntactic synthesis real-time software programs block, proprietary multiport revolving chambered hunting metallic track encasing hermetic cast casing constrained new commerce and transactional exchange methods syntactic synthesis real-time software programs block, and proprietary multiport revolving chambered hunting metallic track encasing hermetic cast casing constrained new commerce and exchange language combinatorial syntactic synthesis real-time software programs block, all proprietary creative original conceptions, engineering utilities, aesthetic architectural designs, authentic compositions, and genuine productions wherefrom herewith concretizing consummate and constructive reduction to practice as a complete sub-loculated cyclical commutative rhombus robotizing real-time microprocessor machine language logic instructing compact integrated new software generator AND-OR closed-circuitry microprocessor engine machine language operating system computing block automatizing real-time holistically steady state synchronized ubiquitous continuum universal executive sub-compartment cyclical commutative rhombus robotizing real-time operating microprocessor syntactic synthesis engine computing system microprogramming language logic instructions entailing, encompassing, comprising, involving, impacting and/or effecting every and all one-time programmable read-only memory (PROM) within a proprietary multiport revolving chambered hunting metallic track encasing hermetic cast casing constrained engine block protective controler soundproof housing and fireclay sealed wall casting fireball impervious carriage data link caster dart castings accumulator central processing unit (CPU) concretizing via conducive appendicular microelectronic templates appended, fixed, soldered, mounted, etched, embedded, copied, inscribed and/or contact printed onto every and all heretofore and hereafter mechanical apparatus microcircuit processing computing motherboards intrinsic and integral as comprehensively suitable, generally pertinent and broadly useful within every and all automatizing high-quality holistically steady state heliocentrically synchronizing ubiquitous hunting continuum commutative rhombus robotizing real-time microprocessing protective housing carriage device apparatus wherefrom hereto successfully embroidering unequivocal absolute resolution proprietary revelatory cognizable relativistic relational melioristic logical positivism syntactic synthesis controlling central processing unit (CPU) fixture originating within every and all iota trace element minutia fueling and/or energizing microprocessor semi-conducting chips, whence perpetually propagating, promulgating and proclaiming galactic alternating angle conduit and alternating scale single independent portal proliferation of artificial semi-conducting microcircuit device article propogating traverse via every and all traditonal mechanical friction and/or chemical reaction to fuel and/or energy power via conduit electrical generation and/or electrical battery, wherefrom hereto via every and all advanced electronic locational systematizing geological and/or seismological processes concretizing innovative transcendent insulated ferromagnetic permeability of article internalized upright orthorhombic tentacular boundless roving antennule steady state transmuting metric conversional transistor transfusing receiver of automatizing high-quality holistically steady state heliocentrically synchronizing ubiquitous hunting continuum commutative rhombus electronic spatiotemporal simultaneous traversal of meta-frequency, wavetrain length wave front electromagnetic continuous spectrum transmission metric unit isogenous single independent portal refractory minutia partible iota beta particle trace element pulse signaling transmission concretizing fuel-efficient and energy power origination catalytic conduits via electrogasdynamics, electrogenesis, electrohydraulic, geomagnetic, gyromagnetic, geokinetic and/or thermodynamic transistorized rheostat regulated galactic staple transfusing partible beta particle trace element galactic iota minutia powered gyroscopic axisymmetrical stabilizing self-impetus protective housing hermetic cast software lock up encasing real-time microprocessor utility engineering didactic rubricating identic heliocentric machine language isogloss unicore isomorphic transfiguration operating system software computing block carriage portable rove bearing articles, apparatuses and megastructures which supplant without limitation, every and all, whereas, it is clearly an undeniable and evidentiary findings of fact, documented reference, logical scientific deduction and intuitive analytical reasoning that aforementioned UCMOST™ information technology unequivocally and uexceptionably offers a novel, unobvious, unknown, unforeseen, epoch and unprecedent innovative technological resolution which supplants every and all of the heretofore unaddressed and unresolved tremendously long-held and enormously heart-felt unmet needs in the relevant art which have risen as a consequence of the proliferation of telecommunications techniques inclusive of, without limitation, every and all inefficient, portentous, menacing, presumptuous and fruitless so-called wire jack line and/or wireless so-called Internet/World Wide Web methodologies, technologies, capacities, procedures, combinations and/or protocols of accessing, gathering, and transporting every and all data and/or information via antiquated, archaic, ancient history and superannuated methodological pooling and/or batch transmission of data and/or information to/from receivers to communicate across short and long-distances alike via time-lagged, hesitant, holding, delayed, imprudent, detrimental and debilitating methodologies via antiquated, archaic, ancient history and superannuated methodologies of identifying, organizing, cataloging, indexing, categorizing, processing and thereupon deriving every and all collections of featured, displayed, projected and/or presented literary, theatrical, melodious and/or aesthetic works involving every and all presumptuous, portentous, pretentious, pernicious, antiquated, archaic, ancient history and superannuated disparate and/or compressible digitalized artistic, theatrical, logic, heurisitc, inference, charactery, numeric, literary, melodius, auditory and video data transport control processing format protocols involving broadcasting, distributing and/or syndicating transmission and/or rebroadcasting, redistributing and/or resyndicating time-lagged spooling and/or batch processing transmission to/from converting receiver inclusive of, without limitation, every and all so-called apostrophe applications inclusive of all the following: whereas so-called windows operating system (WINDOWS) computing graphical software programs; whereas, so-called beginner's all-purpose symbolic instruction code (BASIC) microcomputing languages applications software programs; whereas, so-called disk operating system (MS-DOS) computing operating system software programs; whereas, so-called windows (Media Player) streaming applications computing software programs; whereas, so-called extensible mark-up (XML) seamless linkage interconnect software computing programs; whereas, so-called standard operating applications programs (SOAP) seamless linkage interconnect software computing systems; whereas, so-called dewey decimal system (DEWEY) disparate and/or integrated charactery and numismatic format processing software computing programs; whereas, so-called Movie Pictures Experts Group (MPEG-4) streaming applications computing software programs; whereas, so-called (MP3) streaming digitalized auditory applications computing software programs; whereas, so-called (Plug-and-Play) wire jack line and/or wireless modem driven streaming applications computing software programs; so-called (Real Player) streaming applications computing software programs; whereas, so-called unisys (UUNET) disparate charactery and numismatic format processing software computing programs; whereas, so-called unisys (UNIX) disparate charactery and numismatic format processing software computing programs; whereas, so-called obscured and/or opaquely situated (META) disparate charactery and numismatic format processing software computing programs; whereas, so-called common business oriented languages (COBOL); so-called common microcomputing languages (C; C+; C++); whereas, so-called high level programming algebraic problem-solving languages (FORTRAN); whereas, so-called linux open-source (LINUX) computing software programs; whereas, so-called programming in logic (PROLOG) computing software programs; whereas, so-called toddler, children and/or adolescent educational programming (LOGO) computing software application programs; whereas, so-called defense emergency final contact operating network (DEFCON) computing systems and/or computing software programs; whereas, so-called global positioning system (GPS) computing software programs; whereas, so-called oracle financial application (ORACLE) computing software programs; whereas, so-called linux open-source (LINUX computing operating systems; so-called superannuated basic input/output systems (BIOS) microcomputing language applications software programs; whereas, so-called interfacing open source foundational java (JAVA) streaming computing software programs; whereas, so-called human apostrophe peer-to-peer and business-to-business so-called open source foundational jxta (JXTA) streaming computing software programs; whereas, so-called human apostrophe interfacing (AOL) streaming applications computing software programs; whereas, so-called International Standard Book Number (ISBN) disparate and/or integrated charactery and numismatic format processing software computing programs; whereas, so-called electronic data processing (EDP) disparate and/or integrated charactery and numismatic format processing software computing programs; whereas, so-called just-in-time (JIT) inventory management tracking software computing programs routing and updating methodologies; whereas, so-called activity-based-cost (ABC) inventory management charactery and/or numeric spreadsheet driven software computing programs; so-called ethernet and/or local area network network management switching software processing computing programs; whereas, so-called portfolio asset class allocation (EnCORR) selection and analysis software computing programs; so-called portfolio asset class allocation (EnCORR) optimizing and efficient frontier analyticalsoftware computing programs; so-called electronic money, banking and/or tax preparation and collection (QUICKEN) processing software computing programs; whereas, so-called Transmission Control Protocol/Internetworking Protocol (TCP/IP) internetwork telecommunications accessible software computing programs interfacing methodologies; whereas, so-called Internet file transport protocol (FTP) software computing methodologies; whereas, so-called Internet go for (GOPHER) software computing methodologies; whereas, so-called Internet hyper-text transport protocol (HTTP) widely recognized and speciuosly registered com, .net., .org., .edu, .gov, and .cc interaccessible software computing programs interfacing methodologies; whereas, so-called extracellular and/or extracorporeal wireline and wireless multiplexed apostrophe electrograph, electrostatic, electrothermal, photographic, xerographic, thermographic, thermostatic, thermoelectric, telecast, teletext, teletype, televise, telefacsimile, telegraphy, telemetry, telephony, frame-relay wireline; fixtured wireline, sporadic wire, cable, fiber, film, optic, glass, infrared, radio, television, projection, cinema, radar and/or artificial satellite network storage and/or routing software processing computing programs; whereas, so-called domain name suffix ending labeled universal reference languages (URL) access locational and reference directional interaccessaible software computing programs interfacing methodologies; whereas, so-called world wide web (WWW) internetwork data routing interaccessible software computing programs interfacing methodologies; whereas, so-called hyper-text messaging language (HTML) page formatting interaccessaible software computing programs interfacing methodologies; whereas, so-called wide area network and/or wireless applications programmed (WAP) network management switching; whereas, so-called bluetooth (BLUETOOTH) interoperable computing software programs; whereas, so-called Peripheral Component Interconnect (PCI) interoperable serial busing applications software computing programs; whereas, so-called 802.11 (IEEE) wireless local area (WAN) and/or local area network (LAN) streaming applications computing software programs; whereas, so-called 802.11b (IEEE) wireless high-frequency streaming applications computing software programs; whereas, so-called macintoch (QuickTime) streaming applications computing software programs; whereas, so-called macintoch (MAC) computing operating system graphical software programs; whereas, so-called macintoch disk operating system (MAC) computing graphical software programs; wherefrom evincing every and all antiquated, archaic, ancient history and superannuated methodological pooling and/or batch transmission software programs transport control processing format protocols. Whereas whichever heretofore further evincing every and all multidimensional boisterous, pretentous, portentous and pretentious proliferation of the disparate utilization of feculent, feckless, ineffective, fragmented, unmeritted, inefficient, presumptuous, portentous, pretentious, fruitless, antiquated, archaic, ancient history and superannuated software programs, hardcore computing operating systems, telecommunications and/or telemetry routing and switching infrastructure, personal and/or scalable enterprise network software computing devices, inclusive of, without limitation, every and all hardware computing manufacture of components, factors, constituents, components, ingredients, articles, artifices and/or peripherals heretofore incorrectly preconceived as comprehensively suitable, generally pertient and broadly useful to whichever, whereever and whenever; and whence, wherefrom evincing every and all feculent, feckless, inefficient, portentous, fruitless, antiquated, archaic, ancient history and superannuated real-time processing and/or reprocessing of data and/or information receiver; inclusive of every and all, without limitation, income, capital gains, taxes, charitable contribution, endowment, foundation, inheritance, transactional, estate and/or social security entitlement automated teller machine and/or so-called electronic deposit, withdrawing, transporting, letter of crediting, equity lines, credit lines, revolving credit lines, credit cards, debit cards, prepaid debit cards, check draft cards, certified check drafting, traveling check drafting, merchant, commercial, retail and/or mortgage banking, securities and insurance instrument processing; inclusive of without limitation, every and all variant fixed and portable wire-less and wire jack line pre-paid telephony cards and/or services services wherefrom every and all are heretofore antiquated, archaic, ancient history and superannuated methodologies and processing techniques proliferating so-called telecommunications among depositors in locale and transcontinental fashion in an effort at further propagating boisterous, bolstering, voracious, raptorial, pretentous, portentous and pretentious proliferation of the utilization of antiquated, archaic, ancient history and superannuated methods and processes herewith evinced as specious, fruitless and hereto notwithstanding, wherefrom it is clearly an undeniable and evidentiary findings of fact, documented reference, logical scientific deduction and intuitive analytical reasoning that within the heretofore highly dynamic and volatile global economic market environment tens of thousands of different instruments are traded on several dozen physical, electronic virtual exchange within the so-called U.S. alone, and several thousand mutual fund shares are offered from tens of thousands of investment management companies baiting, tempting and entrapping general depositors to utilize these variant forms of highly-complex, fragmented, antiquated, archaic, ancient history and superannuated physical, electronic, telephony, virtual, dumb terminal and/or webpage exchanges via propagating galactic proliferation of boisterous, pretentous, portentous and pretentious conceptual aids as conduits for every and all feculent, feckless, ineffective, fragmented, unmeritted, inefficient, presumptuous, portentous, pretentious, fruitless, disparate, antiquated, archaic, ancient history and superannuated so-called extracellular and/or extracorporeal wireless and wireless standalone electronic transports and standalone telephony transports actualizing heretofore antiquated, archaic, ancient history and superannuated methodological pooling and batch transmission to/from converting reciever traverse conduit data transport processing to inefficiently catalog and derive indices of literary, melodius, aesthetic and artistic works via audio, video, voice, visual and imaging media entailing, encompassing, comprising, involving, impacting and/or effecting, without limitation, every and all antiquated, archaic, ancient history and superannuated market exchanges residing and/or operating within every and all national sovereign borders of every and all of the industrialized, developed and developing free-market commerce and trade bloc economies within, throughout and transcending a single holistically econometric marketplace environment inclusive of, without limitation, every and all of the following mental, audio, visual, taste, touch and smell oriented apprehending and cognizably appearing, recognizing, identifying, acknowledging, associating, filtering, sorting, organizing, conceptualizing, understanding and comprehending every and all, without limitation, of the following representational abstract conceptual aids: word; character; denumerable; cast, label; category; acronym; trace; notice; letter; mailer; update; release; propaganda; newsletter; hard-cover book; soft-cover paper-back book; magazine; article; publication; periodical; magazine; serial; trace; editorial; newspaper; flier; card; circular; symbol; theme; directive; leaf-letter book; textbook; hypothesis; theory; manuscript; disertation; pamphlet; memorandum, promotion; silkier; announcement; pronouncement; prop; propitious; propel; solicit; advance; tempt; beckon; brochure; report; list; title; art; lyrics; songs; description; methodical; content; material; documentation; compilation; illustration; classification; catalog; manual; non-book; movie; video game; program; performances; enumeration; story; annotate; pictorial; photograph; print; paint; ink; pigment; pen; pencil; dye; chalk; chart; graph; graphic; imaging; figuration; object; prop; array; audio; visual; voice; text; numerical; keying; pulsing; auctioning; laser; morse code; continental code; brailling; dialogue; discourse; literature; theatrical; represent; narrate; speech; comment; partial; heuristic; inference; exposition; announce; monologue; epilogue; speech; commentary; nominative; numeration; charactery; denumerable; charade; characterization; reference; numeric; numismatic; fiction; nuptial; non-fiction; prose; allegory; anagram; black board; drawing board; computer aided designing; clip board; story board; back board; background; time exposure; tincture; tinging; distinguishing; tinsel; tinting; tinkling; tangible property; service mark; trademark; copyright; intangible property; proof; press; copy; post; display; duplication; utilization; echo; reverberation; plea; mendicant; response; report; common talk; message; rumor; static; gossip; summation; relate; feature; presentation; append; fixture; etch; mount; embed; repugn; repulse; reprove; reprimand whether concretizing, actualized, materialized and/or traversed manually, artistically, theatrically, literarily, melodiously and/or gramatically initiated, enacted, performed, propagating and/or promulgated via hereto members of the aforementioned UNIVERSAL POPULACE™ initiatives, schemes, ocurrences, happenings, interactions, processes, methods, practices, movements, proceedings, presentations, filings, submissions, notifications, messaging, recording, activities, actions, events, endeavors, tasks and affairs traversing anywhere, anyplace and anytime via every and all standalone, networked, portable, desktop, laptop, tablet, transmit article, and/or fixtured compressible, compact and/or disparate electrial, battery, radio, television, telephony, telegraphy, typography, photographic and/or solar conduit read and write and/or write-only artifical atmospheric ground wave and/or aeronautical airway casing dish, transmitter, receiver, cassettee, cartridge, pan and/or container inclusive of, without limitation, all the following; microdisk; microfilm; microfiche; microplate; magnetic film; magnetic reel; hard diskette; floppy diskette; magnetic tape drive; magnetic film diskette; magnetic microfilm disk; magnetic microplate disk; paper tape cast; file folder; file drawer; file cabinet; display calculator; cash register; display cash register; display computing article; file storage computing article; teletype interface computing article; teleprompt interface computing article; articled hard core computing disk drive; articled mainframe computing disk drive; articled server computing disk drive; articled network transport routing computing disk drive; articled magnetic reel computing disk drive; articled personal hard computing disk drive; articled desktop hard computing disk drive; articled personal laptop computing disk drive; articled personal tablet computing disk drive; articled personal telephony computing disk drive; articled video game computing disk; articled digital video computing disk; wherefrom whichsoever, every and all whenever and wheresoever entailing, encompassing, comprising, involving, impacting and/or effecting manual, passive and/or below specified automatizing real-time transmission propagating transporting transmuting partible beta particle beam gliding transponder converting receiver conduit aforementioned UCMOST™ real-time processing and/or reprocessing of data and/or information transmission wherefrom hereto collectively realizing optimized and efficient transport flow entailing, encompassing, comprising, involving, effecting and impacting every and all of the distinctively separate and traditionally exclusive specialty areas of holistically steady state continuous spectrum ubiquitous indistinguishably synchronous needs involving aforementioned UCMOST™ real-time processing and/or reprocessing of data and/or information content management, financial services and aforementioned PUBLIC FINANCIALS™ instruments transactional exchange initiatives, schemes, ocurrences, happenings, interactions, processes, methods, practices, movements, proceedings, presentations, filings, submissions, notifications, messaging, recording, activities, actions, events, endeavors, tasks and affairs; wherefrom every and all evidently are legally, undeniably, logically, scientifically and intuitively entail, encompass, comprise, involve, effect and impact every and all accounting, communicating, transporting, energizing, fueling, broadcasting, distributing and financing comprising whichever heretofore and hereafter tens of hundreds of thousands of aforementioned PUBLIC FINANCIALS™ organizations, all of which respectively, independently, autonomously, evidently, undeniably, logically, scientifically and intuitively are hereto discovered to be inevitably necessary and increasingly integral in a capital market transmuting every and all multifaceted industries and multidimensional sectors of the industrialized, developed and developing free-market commerce and trade blocs within, throughout and transcending every and all whicever geographical territories of a single holistically econometric marketplace environment; wherefrom furthermore hereto every and all are hereby necessarily concretizing as streamlined, alternating scale, inseparable, seamless and naturally wrapped, twisted, convoluted, coupled and combined heretofore and hereafter as combinatorial with every and all clients, customers, consumers, member-subscribers, constituents, creditors, shareholders, stakeholders, so-called U.S. depositors, so-called U.S. citizen taxpayers, foreign national depositors, foreign national taxpayers, global depositors, universal citizenry and general populace, every and all of whom are also respectively, independently, autonomously, evidently, undeniably, logically, scientifically and intuitively found to be inevitably necessary and increasingly integral in a capital market heretofore and hereafter irrespective of whether whichever resides and/or operates heretofore and hereafter anytime, anywhere and anyplace within, throughout and/or transcending whichever geographical territories of a single holistically econometric marketplace environment, wherefrom moreover every and all whose inherent aim, letter, nature, breadth, sound, depth, spirit and scope herewith invokes, without limitation, across-the-board traversal of every and all of the hundreds of millions undeniably, evidentiary, logically, scientifically, intutively and necessarily depositors inclusive of undeniably, evidentiary, logically, scientifically, intutively and necessarily investors, involving: so-called personal holding; so-called personal fixtured; so-called proprietary holding; so-called proprietary fixtured; so-called partnership holding; so-called partnership fixtured; so-called company holding; so-called company fixtured; so-called firm holding; so-called firm fixtured; so-called corporation holding; so-called corporation fixtured; so-called incorporation holding; so-called incorporation fixtured; so-called commercial holding; so-called commercial fixtured; so-called franchise holding; so-called franchise fixtured; so-called union holding; so-called union fixtured; so-called group holding; so-called group fixtured; so-called not-for-profit holding; so-called not-for-profit fixtured; so-called foundation holding; so-called foundation fixtured; so-called endowment holding; so-called endownment fixtured; so-called association holding; so-called association fixtured; so-called league holding; so-called league fixtured; so-called town holding; so-called town fixtured; so-called locale holding; so-called locale fixtured; so-called city holding; so-called city fixtured; so-called municipal holding; so-called municipal fixtured; so-called metropolis holding; so-called metropolis fixtured; so-called county holding; so-called county fixtured; so-called district holding; so-called district fixtured; so-called province holding; so-called province fixtured; so-called state holding; so-called state fixtured; so-called federal holding; so-called federal fixtured; so-called country holding; so-called country fixtured; so-called nation holding; so-called nation fixtured; so-called transnational holding; so-called transnational fixtured; so-called multinational holding; so-called multinational fixtured; so-called federation holding; and so-called federation fixtured whichever private individuals, private and/or public commercial, labor unionized, group associational and/or public governance legal and/or status of existence above and below mentioned are undeniably, evidentiary, logically, scientifically and intuitively members of a universal citizenry, every and all of whom further, without limitation, are respectively, independently, autonomously, evidently, undeniably, logically, scientifically and intuitively found to be inevitably necessary and increasingly integral members of a capital market, heretofore and hereafter irrespective of whether whichever resides and/or operates anytime, anywhere and anyplace within, throughout and/or transcending whichever geographical territories of a single holistically econometric marketplace environment, wherefrom hereto innate conception, terminological conveyance, indivisible rubrical, syntactic oralformulaic, systematic arrangement, artistic construct, melodious lyrics, denominative literateness and thereat proprietary multiport revolving chambered hunting metallic track encasing hermetic new software lock up cast casing constrained real-time microprocessor engineering machine language unicore operating system software computing block keyhole combinational code heretofore and hereafter above and below mentioned individual members of the aforementioned UNIVERSAL POPULACE™, proprietary trademark and service mark is exclusive proprietary intellectual property belonging exclusively and unequivocally to Juan Carlos Castro. Whereas aforementioned UCMOST™ information technology establishes the solidifying, unifying and cohesively integrated foundation necessary to concretize optimized and efficient transport flow of holistically steady state continuous spectrum ubiquitous indistinguishably synchronous needs involving aforementioned UCMOST™ real-time processing and/or reprocessing of data and/or information content management, financial services and aforementioned PUBLIC FINANCIALS™ instruments transactional exchange initiatives, schemes, ocurrences, happenings, interactions, processes, methods, practices, movements, proceedings, presentations, filings, submissions, notifications, messaging, recording, activities, actions, events, endeavors, tasks and affairs between and among members of the aforementioned PUBLIC FINANCIALS™ organizations, inclusive of individual members of the aforementioned UNIVERSAL POPULACE™; whereform enabling each individually and all collectively to mitigate debilitating systematic volatility in aforementioned PUBLIC FINANCIALS™ statements which clearly, undeniably, logically, scientifically and intutively derives and/or drives every and all unnecessary, unwarranted and unjustificable debilitating increases in systematic volatilty within aforementioned PUBLIC FINANCIALS™ instruments whereas moreover aformentioned UCMOST information technology further enables individual members of the aforementioned UNIVERSAL POPULACE™ to protect, sustain and expand their treasure accounting, financial fueling and econometric energizing by mitigating every and all unnecessary, unwarranted and unjustificable debilitating increases in systematic volatilty inclusive of, without limitation, mitigating unnecessary, unwarranted and unjustifiably debilitating increases in the cost of capital, each of which inherently and intrinsically is clearly, undeniably, logically, scientifically and intutively derived and/or drives that market valuation of aforementioned PUBLIC FINANCIALS™ instruments within capital market, and thus, directly and/or indirectly negatively impacts and/or effects the treasure accounting, financial fueling and econometric energizing of individual members of the aforementioned UNIVERSAL POPULACE™ which is further clearly, undeniably, logically, scientifically and intutively a calculated derivative function of the individual market valuations of each and every aforementioned PUBLIC FINANCIALS™ instruments registered and/or listed within an capital market, wherefrom unequivocally and in collective fashion evincing a single global econometric aforementioned efficient UNIVERSAL CAPITAL MARKET™. Wherefrom, every and all, heretofore and hereafter, collection of information technologies embroidered as elements, constituents, factors and ingredients involved within the novel, unobvious, unique, unknown, unforeseen, unprecedented, ease of use and panacean cutting-edge technological innovation invoked within aforementioned UCMOST™ information technology is furthermore comprehensively suitable, generally pertinent and broadly useful utility and design formulation herewith existent innovative developments and technological advancements applicable to every and all eamlessly and naturally wrapped, twisted, mixed, convoluted, embroidered and combined aforementioned PUBLIC FINANCIALS™ statements in connection with, every and all seamlessly and naturally wrapped, twisted, mixed, convoluted, embroidered and combined aforementioned PUBLIC FINANCIALS™ instruments clearly, undeniably, logically, scientifically and intuitively evinced from every and all individual and/or collective individual members of the aforementioned UNIVERSAL POPULACE™, each of whom are undeniably, respectively, independently, autonomously, evidently, undeniably, logically, scientifically and intuitively the exclusive drivers of every and all transactional exchange initiatives, schemes, ocurrences, happenings, interactions, processes, methods, practices, movements, proceedings, presentations, filings, submissions, notifications, messaging, recording, activities, actions, events, endeavors, tasks and affairs within a capital market, and thus UCMOST information technology is thereto further comprehensively suitable, generally pertinent and broadly useful to mitigating exponential increases in tempestuous exponentially detrimental systematic volatility and exponential increases in tempestuous exponentially debilitating cost of capital in a single holistically econometric marketplace environment to protect, sustain and expand the aforementioned PUBLIC FINANCIALS™ statements by preculding, preventing and mitigating every and all, without limitation, uncertainties, speculations and/or fraudulent transactional exchange initiatives, schemes, ocurrences, happenings, interactions, processes, methods, practices, movements, proceedings, presentations, filings, submissions, notifications, messaging, recording, activities, actions, events, endeavors, tasks and affairs within a capital market, which but for invoking every and all of the comprehensivley suitably, generally pertient and broadly useful elements, components, constituents, factors and ingredients embroidered within aforementiond UCMOST™ information technology clearly, undeniably, logically, scientificaly and intuitively exsist thereto, wherefrom each and every member irrespective of whether derived individually and collectively within, throughout and transcending the national sovereign so-called borders of every and all industrialized, developed and developing free-market trade block economies within, throughout and transcending a single holistically econometric marketplace environment to ensure the cash liquidity, finanical solvency and ecnomic stablity of an aforementioned efficient UNIVERSAL CAPITAL MARKET™. Whereas, it is an undeniable and evidentiary findings of fact, documented reference, logical scientific deduction and intuitive analytical reasoning that whichever respective aforementioned PUBLIC FINANCIALS™ instruments and aforementioned PUBLIC FINANCIALS™ statements from members of the aforementioned UNIVERSAL POPULACE™ whichever every and all are furthermore undeniably, logically, scientifically and intuitively deduced, apprehended and invoked as necessarily integrated, critically important and increasingly integral members of the aforementioned UNIVERSAL POPULACE™ invoked within aforementioned UCMOST™ information technology is comprehensively suitable, generally pertinent and broadly useful to intrinsically filing every and all domestic and/or expatriate domain certified periodic, interim and annual Personal Financial Statements (PFS) inclusive of certified payment on income, capital gains and/or other licenses, taxes, rates, assessments, charges, fees, tariffs, sur-charges inclusive of every and all pricing, costing, operating, franchising, leasing, purchasing, financing and/or commissioning proposed, stipulated, substantiated, justified, verified, traversed, enacted, levied, imposed, rated, assessed, certified, propagating and subsequent promulgation respectively via legitimate and instrinsically certified hereto members of the aforementioned UNIVERSAL POPULACE™ filing and collection of money payments of every and all feculent, feckless, ineffective, fragmented, unmeritted, inefficient, presumptuous, portentous, pretentious, fruitless, disparate, antiquated, archaic, ancient history and superannuated so-called U.S. Department of Treasury (so-called U.S. Treasury), ancient history internal revenue service agency generator scheduled and/or unscheduled Forms and Schedules inclusive of so-called U.S. Treasury Form 1040 in connection with applicable unitemized and basic so-called U.S. Treasury Schedule A, B, and D and/or so-called U.S. Treasury Form 1040-EZ from members of the aforementioned UNIVERSAL POPULACE™, inclusive of the more itemized and complex so-called U.S. Treasury Form 1040 in connection with a so-called U.S. Treasury Schedule C, wherefrom further hereto invoked within aforementioned UCMOST™ information technology is comprehensively suitable, generally pertinent and broadly useful to intrinsically certified filing every and all interim so-called U.S. Securities and Exchange Commission (so-called U.S. SEC) processing heretofore via the anciet history Electronic Data Gathering and Automated Retrieval (EDGAR) UCMOST™ information system wherefrom hereto interim so-called U.S. Form 8-K with a standard fifteen-day time-lagged inabsentia, hardship, inanition, skidding, stalling, hesitant, holding, refusing and restraining unscheduled aforementioned PUBLIC FINANCIALS™ statements, interim so-called U.S. SEC Form 10-Q with a standard forty-five time-lagged inabsentia, hardship, inanition, skidding, stalling, hesitant, holding, refusing and restraining aforementioned PUBLIC FINANCIALS™ statements, interim General Purpose Financial Statements (GPFS) aforementioned PUBLIC FINANCIALS™ statements, interim so-called U.S. SEC Form 10-QSB aforementioned PUBLIC FINANCIALS™ statements from small business registrants, interim so-called U.S. SEC Form S4463G aforementioned PUBLIC FINANCIALS™ statements filings from beneficial owners, interim so-called U.S. SEC Form S4463G/A aforementioned PUBLIC FINANCIALS™ statements amended filings from beneficial owners, interim so-called U.S. SEC Form DEF 13-F aforementioned PUBLIC FINANCIALS™ statements comprehensively suitable, generally pertinent and broadly useful to reporting on aforementioned PUBLIC FINANCIALS™ instruments from banking, securities, insurance related public organizations inlcusive of, without limitation, whichever furthermore transactional exchange advisers, transactional exchange companies, foundations, endownments and pension funds wherefrom hereto terminological denominatively part and form members of the aforementioned UNIVERSAL POPULACE™, interim so-called U.S. SEC Form DEF 14-A aforementioned PUBLIC FINANCIALS™ statements comprehensively suitable, generally pertinent and broadly useful to proxy voting from members of the aforementioned UNIVERSAL POPULACE™, interim so-called U.S. SEC Form 497 aforementioned PUBLIC FINANCIALS™ statements comprehensively suitable, generally pertinent and broadly useful to initial filing registration prospectus from transactional exchange company related members of the aforementioned UNIVERSAL POPULACE™, interim so-called U.S. SEC Form 24F-2NT aforementioned PUBLIC FINANCIALS™ statements of registration aforementioned PUBLIC FINANCIALS™ instruments from transactional exchange company related members of the aforementioned UNIVERSAL POPULACE™, interim so-called U.S. SEC Form N-30D aforementioned PUBLIC FINANCIALS™ statements comprehensively suitable, generally pertinent and broadly useful to semi-annual reporting from transactional exchange company related members of the aforementioned UNIVERSAL POPULACE™, initial so-called U.S. SEC Form 3 aforementioned PUBLIC FINANCIALS™ statements comprehensively suitable, generally pertinent and broadly useful to initial filing of directors, officers and persons or public organizations owning more than 10% of any class from members of the aforementioned UNIVERSAL POPULACE™, interim so-called U.S. SEC Form 4 aforementioned PUBLIC FINANCIALS™ statements comprehensively suitable, generally pertinent and broadly useful to filing intention of disolvement of positions from directors, officers and persons and/or public organizations owning more than 10% aforementioned PUBLIC FINANCIALS™ instruments of any class from members of the aforementioned UNIVERSAL POPULACE™, wherefrom further hereto annual so-called U.S. SEC Form 10-K with a standard ninety-day time-lagged inabsentia, hardship, inanition, skidding, stalling, hesitant, holding, refusing and restraining aforementioned PUBLIC FINANCIALS™ statements, annual Comprehensive Annual Financial Reports (CAFR) aforementioned PUBLIC FINANCIALS™ statements, annual so-called U.S. SEC Form 20-F aforementioned PUBLIC FINANCIALS™ statements and/or annual so-called U.S. SEC Form 5 aforementioned PUBLIC FINANCIALS™ statements respectively from domestic, foreign registrants and/or directors, officers and persons and/or public organizations owning more than 10% aforementioned PUBLIC FINANCIALS™ instruments of any class from members of the aforementioned UNIVERSAL POPULACE™ in combination with the aforementioned PUBLIC FINANCIALS™ instruments to effectuate management decisions regarding the operating performance, transactional exchange and financial profitability members of the aforementioned UNIVERSAL POPULACE™, wherefrom hereto evidently deriving, inducing and invoking further terminological denominative of every and all aforementioned PUBLIC FINANCIALS™ instruments as comprehensively suitable, generally pertinent and broadly useful via streamlined, alternating scale, inseparable, seamless and natural wrapping, interlacing, coiling, coupling, combining and interlocking within every and all aforementioned PUBLIC FINANCIALS™ statements traversing inclusive of, without limitation, every and all other industries and sectors in a single holistically econometric marketplace environment beyond the following specified multifaceted industries and multidimensional sectors entailing, encompassing, comprising, involving, impacting and/or effecting banking, securities and insurance, wherefrom hereto it is clearly an undeniable and evidentiary findings of fact, documented reference, logical scientific deduction and intuitive analytical reasoning that every and all of the interim aforementioned PUBLIC FINANCIALS™ statements from either members of the aforementioned UNIVERSAL POPULACE™ nor members of the aforementioned UNIVERSAL POPULACE™ are independently audited for the benefit of an aforementioned efficient UNIVERSAL CAPITAL MARKET™. Wherefrom terminological denominate syntactic synthesis invoking aforementioned UCMOST™ information technology is comprehensively suitable, generally pertinent and broadly useful to every and all, without limitation, aforementioned PUBLIC FINANCIALS™ instruments hereto harnessed, wrapped, leveraged and unequivocally apprehended in connection with every and all, without limitation, of the aforementioned PUBLIC FINANCIALS™ statements from every and all individual members of the aforementioned UNIVERSAL POPULACE™ which are heretofore and hereafter undeniably, logically, scientifically and intuitively comprehensively suitable, generally pertient and broadly useful to every and all real-time processing and/or reprocessing of data and/or information receiver entailing, encompassing, comprising, involving, impacting and/or effecting every and all asset, liability and residual equity ledger balance accounts of every and all private individuals inclusive, without limitation, of every and all public organizations within, throughout and transcending the national sovereign so-called borders of every and all of the industrialized, developed and developing free-market commerce and trade bloc economies within a single holistically econometric marketplace environment; wherefrom whichever further entailing, encompassing, comprising, involving, impacting and/or effecting every and all legal interstate and/or intrastrate Uniform Commercial Code (UCC), inclusive of legal transnational and/or transnational commercial mercantile free-trade agreements transcending national sovereign so-called borders of trade block economies, inclusive of, without limitation, every and all utility and design innovation stemming from effortless reseach development and technological advancement whereby mitigating every and all polarizing situations and/or unnecessary concerns involving: the Anti-Ballistic Misssle Treaty; the North American Free Trade Agreement (NAFTA); the European Economic Union (EEU); the Asian-Pacific Economic Community (APEC); wherefrom aforementioned PUBLIC FINANCIALS™ statements from every and all individual members of the aforementioned UNIVERSAL POPULACE™ which are heretofore and hereafter undeniably, logically, scientifically and intuitively comprehensively suitable, generally pertient and broadly useful to every and all real-time processing and/or reprocessing of data and/or information receiver entailing, encompassing, comprising, involving, impacting and/or effecting every and all ledger trace account, trial balance, cash flow, profit and loss and/or balance sheet; wherefrom whichever inherently, intrinsically, clearly, undeniably, logically, scientifically and intutively deriving and/or driving every and all personal financial statement inclusive of, without limitation, every and all public statement of revenue, cost of goods sold, depreciation expenditure, other operational expenditure, interest expenditure if applicable, taxes payable and/or deferred taxes payable, and residual profit if available, public statement of financial position or so-called public balance sheet, and public statement of cash flows inherently derived from every and all cash inflow and/or outflow from ledger account receivables, ledger account payables, acquisitions of property, plant, boiler and machinery equipment, ledger account short-term borrowing, ledger account long-term borrowing, new residual equity issuance and potential payment of dividends which occur, happen and/or transpire respectively from accounting, operating, exchanging, administrating, reconciling, managing and financing, inclusive of, without limitation, every and all distinctively separate and traditionally exclusive private and/or public off-balance sheet statement of financial position whichever owned as majority and/or minority participations, wherefrom further hereto every and all of which entail, encompass, comprise, involve, effect and impact every and all current and long-term ledger account asset receivable balances, ledger account asset Universal Character Set (UCS) and/or Universal Decimal System (UDS) driven and/or effectuated Universal Product Code (UPC) inventory balances, ledger account asset or potentially liability balances, ledger account other long-term asset balances, ledger account liability payable balances, ledger account interest liability payable balances, ledger account other long-term liability payable balances, ledger account additional paid-in capital residual equity balances, ledger account structural capitalization residual equity balances, and other ledger account alternative structural capitalization residual equity balances, wherefrom further hereto every and all entail, encompass, comprise, involve, effect and impact every and all assets, liabilities and/or residual equities from private and/or public sub-unit, unit, divisional, segmented and/or consolidated elements, components, factors, constituents and ingredients comprising aforementioned PUBLIC FINANCIALS™ statements which inherently involve multifaceted and multidimensional non-financial account headings and non-financal contra-account headings entailing, encompassing, comprising, involving, impacting and/or effecting intrinsically and inherently, without limitation, every and all real-time processing and/or reprocessing of data and/or information receiver from every and all general populace, elected officials, appointed dignitaries, appointed diplomats, public/private organizations, sovereign government entities and/or not-for-profit organizations all of whom are respectively, independently, autonomously, evidently, undeniably, logically, scientifically and intuitively found to be inevitably necessary and increasingly integral member participants within a single holistically econometric marketplace environment. Furthermore, it is an undenaible and evidentiary findings of fact, documented reference, logical scientific deduction and intuitive analytical reasoning that, without limitation, every and all of the hundreds of millions of members of the aforementioned UNIVERSAL POPULACE are heretofore continuously subject to harming, damaging, inuring, insistent, insinuating, imposing, pestilent, impetuous, importune, pestiferous, condescending and insolent enthralling, hindering, entrapping, pretending, miring, fatiguing, maleficience, harassing, engulfing, pressing, malevolent, presuming, imprinting, malicious, pestering and oppressing tactics from aforementioned fragmenting capital market inefficiencies, wherefrom the single global econometric marketplace environment heretofore evinces a complete lack of every and all techniques, designs, systems, routines, devices, manners, modes, fashions, forms, formats, factors, objects, parts, segments, elements, components, constituents, ingredients, processes, methods and combinations of panacean cutting-edge and innovative information technologies entailing, encompassing, comprising, involving, impacting and/or effecting every and all basic functional elements, necessary interactions and integral transactional exchange initiatives, schemes, ocurrences, happenings, interactions, processes, methods, practices, movements, proceedings, presentations, filings, submissions, notifications, messaging, recording, activities, actions, events, endeavors, tasks and affairs found prevalent within an aforementioned efficient UNIVERSAL CAPITAL MARKET™ propagating via efficient, effective, functional and integrated streamlined, alternating scale, inseparable, seamless and natural wrapping, interlacing, coiling, coupling, combining and interlocking techniques, designs, systems, routines, devices, manners, modes, fashions, forms, formats, factors, objects, parts, segments, elements, components, constituents, ingredients, processes, methods and combinations entailing, encompassing, comprising, involving, impacting and/or effecting automatizing real-time holistically steady state synchronized ubiquitous continuum real-time rhombus microprocessing instantaneous transmission and receiver transforming traverse conduit aforementioned UCMOST™ real-time processing and/or reprocessing involving every and all public accounting, transport reconciling, independent auditing and financial reporting inclusive of, without limitation, involving every and all order-entry quotation, matching, clearance, execution, settlement and exchange of insurance, risk financing, credit, cash management, investment banking and aforementioned PUBLIC FINANCIALS™ instruments transactional exchange initiatives, schemes, ocurrences, happenings, interactions, processes, methods, practices, movements, proceedings, presentations, filings, submissions, notifications, messaging, recording, activities, actions, events, endeavors, tasks and affairs. Thus, on every and all issues, matters, topics, features, elements, constituents, factors and/or ingredients entailing, encompassing, comprising, involving, impacting and/or effecting the main embodiments of my invention the reader's attention is directed to the drawing(s) below wherefrom is grasped a visual and graphical aesthetic design of a rough outline sketch to entirely and completely understand and comprehend the description and operation of aforementioned UCMOST™ information technology offered below. Whereas, it is an undeniable and evidentiary findings of fact, documented reference, logical scientific deduction and intutive analystical reasoning that every and all aforementioned PUBLIC FINANCIALS™ statements are simply a composite form of every and all economic resources, financial transactions, operational occurrences, recurring events, miscellaneous items, and cost or expense driven initiatives, schemes, ocurrences, happenings, interactions, processes, methods, practices, movements, proceedings, messaging, presentations, notifications, filings, submissions, records, activities, actions, events, endeavors, tasks and affairs, and more specifically, forecasting the present values of future cash flows, earnings, taxes, profits and intangible valuations which occur, happen, happenstance and/or transpire within the course of normal and/or atypical operational, administrative and/or management activities of transactions which are effectuated between and among any one or any number of aforementioned PUBLIC FINANCIALS™ organizations inclusive of, without limitation, one or any number of members from the members of the aforementioned UNIVERSAL POPULACE™; wherefrom every and all such aforementioned PUBLIC FINANCIALS™ statements from aforementioned PUBLIC FINANCIALS™ organizations inclusive of members of members of the aforementioned UNIVERSAL POPULACE™ are clearly, undeniably, logically, scientifically and intutively found to display similar standard patters, similar standard trends, similar standard formats and and similary standard alignment. In further reviewing these similar standard so-called patters, trends, formats and alignments, direction requisite strives for attention to all abstract conceptual review and visualization of a character and numeric premised calculative spreadsheet file comprised hypothetically of infinite rows and columns; wherefrom as it pertains to aforementioned PUBLIC FINANCIALS™ statements from aforementioned PUBLIC FINANCIALS™ organizations inclusive of, without limitation, individual members of the aforementioned UNIVERSAL POPULACE™ we cognitatively identify that every column is labeled with a respective year or filing date wherefrom with respect to aforementioned PUBLIC FINANCIALS™ organizations legal requisites and prudent disclosure requirements suggest a presentation of three years of so-called aforementioned PUBLIC FINANCIALS™ statements, if operating for such time. Whereas, it is an undeniable and evidentiary findings of fact, documented reference, logical scientific deduction and intutive analytical reasoning that every and all aforementioned PUBLIC FINANCIALS™ statements are simple mathematical cummulative calculations which are performed on financial data and include related descriptive information that generates a sub-unit, unit, department, division and/or consolidation from an aforementioned PUBLIC FINAICALS™ organization. As a function of any legal existence of tens of hundreds of thousands of aforementioned PUBLIC FINAICALS™ organization within the marketplace organizations act, perform and undertake similar, if not, almost identical patters, trends, formats and objectives in comparison with living human existence of hundreds of millions of members of the aformentioned UNIVERSAL POPULACE™ which necessarily within a single holistically econometric marketplace environment inevitably heretofore and hereafter must necessarily work to serve others to gather and necessarily expend economic resources, predominately and heretofore necessarily in the form of monetary currency denominative paper and/or electronic charactery and/or numismatics wherefrom heretofore are exclusively available via so-called antiquated, archaic, ancient history and superannuated banks to therefrom utilize via hard cash, check draft and/or electronic funds transfer to accomplish their objectives and facilitate the sustenance, growth, development and/or expansion as an aforementioned PUBLIC FINAICALST organization and/or member of the aformentioned UNIVERSAL POPULACE™. Whereas, it is an undeniable and evidentiary findings of fact, documented reference, logical scientific deduction and intutive analytical reasoning that related information involving every and all economic resources, financial transactions, operational occurrences, recurring events, miscellaneous items, and cost or expense driven initiatives, schemes, ocurrences, happenings, interactions, processes, methods, practices, movements, proceedings, messaging, presentations, notifications, filings, submissions, records, activities, actions, events, endeavors, tasks and affairs, and more specifically, forecasting the present values of future cash flows, earnings, taxes, profits and intangible valuations which occur, happen, happenstance and/or transpire within the course of normal and/or atypical operational, administrative and/or management activities of transactions which are effectuated between and among any one or any number of aforementioned PUBLIC FINANCIALS™ organizations inclusive of, without limitation, one or any number of members from the members of the aforementioned UNIVERSAL POPULACE™ retrieve on a recurring and/or spontaneous basis to create trace entries which are compiled and posted to every and all ledgers to update the account balances applicable to the so-called statement of financials position, statement of revenues and expenditures, statement of changes in cash flows and statement of changes in participating member residual equity. It is further an undeniably and evidetiary findings of fact, documented reference, logical scientific deduction and intuitive analytical reasoning that every and all dart trace entries must necessarily be received, formatted, organized, compiled, processed and instantaneously be reconciled to a master general ledger attributed to or generated from each and every member of the members of the aforementioned UNIVERSAL POPULACE™ inclusive of, without limitation, every and all sub-unit, unit, department, segment, division irrespective of whether integrated and/or disparate from the balance sheet from members of the aforementioned PUBLIC FINANCIALS™ organizations to evince any and all whatsoever utmost truth and steadfast adherence to ensuring the highest levels of utmost quality, honesty, integrity, reliability, validity, trustworthiness, comprehensiveness and understandability, wherefrom the lack of any and all thereof renders to notion of measuring econometric transactional activities a complete and unequivocal fraud which inherently and intrinsically negatively impacts and/or effects, directly and/or indirectly, the cash liquidity, financial solvency and economic stablity of every and all individual members of the aforementioned UNIVERSAL POPULACE™ inclusive of, without limitation, the cash liquidity, financial solvency and economic stablity of a single global econometric marketplace environement necessarily integrated via innate demand for the trade of products, goods, services and supplies to advance the human race inclusive of the holistic work force of planet earth. Whereas, with respect to the so-called statement of revenues and expenditures, is basically identified columns labeled by year, typically with steadfast accordance to heretofore guidelines presenting three years of charactery and numismatic decimalized metric system denumerals. Whereas, with respect to the so-called statement of revenues and expenditures, is basically identified rows which take the form of categorized composite descriptive items, further originating along its countepart axis top-line so-called revenues heretofore facilitating a line item for allowances, whereform compiling net revenues with footnotes on all receivables and allowances thereto. Whereas, with respect to subservient rows within the statement of revenues and expenditures is identified categorized composite line items of the costs of goods sold, sales, general and administrative expenses, and possible extraordinary items, then taxes, and net income. Whereas moreover, with respect to the so-called statement of fianncials position, is basically identified columns from these statements are labeled with their respective year or filing date and prudent disclosure requirements requisite a minimum of three years, if operational for such time. Whereas, with respect to the so-called statement of financials position, is basically identified row line item categorized composite decimalized metric system numismatic valuations attributed to so-called assets, so-called liabilities, and so-called residual equity ledgers representing aggregate summation of multidimensional dart trace ledger balance accounts posted on a recurring and/or spontaneous basis. Whereas moreover, with respect to the so-called statement of cash flows is basically identified as columns labeled with their respective year or filing date and prudent disclosure requirements requisite a minimum of three years, if operational for such time. Wherefrom, with respect to the so-called statement of cash flows is basically identified various row line items representing three major categorizations which evince every and all cumulative operating, investing and financing results of a member of the aforementioned PUBLIC FINANCIALS™ organizations and/or a member of the members of the aforementioned UNIVERSAL POPULACE™ resulting in a so-called period-to-period change in cash from the aforementioned members of the UNIVERSAL POPULACE™. Moreover, with respect to the so-called statement of residual equity, is basically identified columns within these statements are labeled with their respective year or filing date and prudent disclosure requirements requisite a minimum of three years, if operational for such time. Whereas, moreover with respect to the so-called statement of residual equity, is basically identified row line item basically evincing net equity decimalized metric system numismatic valuations is identified descriptive composite categorization of additional net income/net loss decimalized metric system numismatic valuations adjusting for every and all adjustments for dismantling segment operations and/or intangible so-called goodwill during so-called period of time under review. Whereas, furthermore with respect to the row line items within the statement of residual equity is basically identified representations of the so-called period-to-period changes to residual equity valuation attributed thereto net every and all so-called dividends paid out to so-called residual equity participants during the so-called period under review. Wherefrom, it is a undeniably and evidentiary findings of fact, documented reference, logical scientific decuction and intutive analystical reasoning that at a basic minimum full circle loop reconciliation, every and all change in cash dervied from the statement of cash flows during any so-called operational period-to-period analytical operational review must be perfectly positvely correlated and perfectly positively reconciled with the change in short-term currency ledger account balance during the exact same period-to-period analytical operational review involving the statement of financials position; wherefrom simultaneously and continuously ensuring parity among the composite aggregate values of so-called assets, so-called liabilities, and so-called residual equities by so-called closing and/or heretofore arbitrarily affecting performance measurement of the period-to-period operational review to both the so-called changes in numismatic decimalized metric system values within the statemetn of cash flows with the so-called numismatic decimalized metric system values of the related ledger balance accounts within the statement of financial positions; moreover, failure to provide this basic evidence disintegrates any and all whatsoever utmost truth and steadfast adherence to ensuring the highest levels of utmost quality, honesty, integrity, reliability, validity, trustworthiness, comprehensiveness and understandability to hundreds of millions of individual members of the aforementioned UNIVERSAL POPULACE™ which reside and/or operatate anywhere, anytime and anyplace but whose entire livelihood and walks of life necessarily, undeniably, logically, scientifically and intutively depend on effectuating efficient, effective, streamlined, well-informed, objective, prudent, risk-managed, self-impetus and self-assured short/long-term accounting, communicating, transporting, energizing, fueling, broadcasting, distributing and financing decisions therefrom, whereform every and all aforementioned PUBLIC FINANCIALS™ statements from members of the aforementioned PUBLIC FINANCIALS™ organizations intrinsically and inherently impact and/or effect their short and long-term cash liquidity, finanical solvency and economic stablity involving every and all products, goods, services and supplies entailing, encompassing, comprising, involving, impacting and effecting every and all aforementioned PUBLIC FINANCIALS™ instruments, which over the short/long-term diminish their basic levels of subsistence and acess to wealth and/or prosperity with prevalence, accessibility and abundance of aforementioned PUBLIC FINANCIALS™ instruments available to them to leverage, purchase and/or dispose of at their leisure and will as individuals and their heirdom lineage for generations of spatiotemporal existence within industrialized, developed and developed free-market commerce and trade bloc economies within, throughout and transcending a single holistically econometric marketplace environment on planet earth. This general abstract conceptual visual glimpse of the similar standard so-called patters, trends, formats and alignments of aforementiond PUBLIC FINANCIALS™ statements inclusive of, without limitation, a basic review of so-called double-entry accounting methodology premised on offering a full circle loop of trace entries made thereto wherefrom facilitating a so-called reliable and so-called verifiable accounting and financial reporting of every and all so-called economic resources, financial transactions, operational occurrences, recurring events, miscellaneous items, and cost or expense driven initiatives, schemes, ocurrences, happenings, interactions, processes, methods, practices, movements, proceedings, messaging, presentations, notifications, filings, submissions, records, activities, actions, events, endeavors, tasks and affairs, and more specifically, forecasting the present values of future cash flows, earnings, taxes, profits and intangible valuations which occur, happen, happenstance and/or transpire within the course of normal and/or atypical operational, administrative and/or management activities of transactions which are effectuated between and among any one or any number of aforementioned PUBLIC FINANCIALS™ organizations inclusive of, without limitation, one or any number of members from the members of the aforementioned UNIVERSAL POPULACE™; wherefrom every and all such aforementioned PUBLIC FINANCIALS™ statements from aforementioned PUBLIC FINANCIALS™ organizations inclusive of members of members of the aforementioned UNIVERSAL POPULACE™. It is an undeniably and evidentiary finding of fact, documented reference, logical scientific deduction and intuitive analytical reasoning that every and all aforementioned aforementioned PUBLIC FINANCIALS™ organizations whether registered and listed within a formalized and licensed so-called exchange must necessarily ensure utmost truth and steadfast adherence to ensuring the highest levels of utmost quality, honesty, integrity, reliability, validity, trustworthiness, comprehensiveness and understandability to hundreds of millions of individual members of the aforementioned UNIVERSAL POPULACE™ which reside and/or operatate anywhere, anytime and anyplace because whether operating and/or residing within any one particular jurisdiction of geographically zoned territorial space or otherwise every and all occur, happen, happenstance and/or transpire within the course of normal and/or atypical operational, administrative and/or management activities of transactional economic resources, financial transactions, operational occurrences, recurring events, miscellaneous items, and cost or expense driven initiatives, schemes, ocurrences, happenings, interactions, processes, methods, practices, movements, proceedings, messaging, presentations, notifications, filings, submissions, records, activities, actions, events, endeavors, tasks and affairs, directly and/or indirectly, impact the cosmos of a single transnational econometric marketplace environment which impacts and/or effects every and all elementary and basic levels of subsistence and acess to wealth and/or prosperity with prevalence, accessibility and abundance of econometric physicalistic products, goods, services and/or supplies of multitudes of individual members of the aforementioned UNIVERSAL POPULACE™. Whereas, directing a reader's preoccupied and prepossessed attention to UCMOST™ drawing(s) below evincing ornamenting structural and architectural design within FIG. 1, wherefrom is identified a comprehensively suitable, generally pertinent and broadly useful UCMOST™ information technology which is a novel, unobvious, unknown, unforeseen, unprecedented, epoch, paper-less, ease of use, fruitful and opportune panacean cutting-edge breakthrough utility engineering and groundbreaking technological architectural design innovation which is a self-contained, fault-tolerant, anonymous, independent, autonomous, impartial, apolitical, streamlined, alternating scale and inseparable proprietary multiport revolving chambered hunting metallic track encasing hermetic cast casing constrained new software commutative rhombus robotizing real-time microprocessor engineering machine language unicore operating system software computing block whose universal dominion domain outline is comprehensively suitable, generally pertinent and broadly useful wherefrom hereto entailing, encompassing, comprising, involving, impacting and/or effecting automatizing real-time holistically steady state synchronized ubiquitous continuum sub-loculated cyclical commutative rhombus robotizing real-time operating microprocessor engine computing system logic instructions propagating, promulgating and proclaiming across-the-board traversal of breakthrough technological and groundbreaking innovative developments and advancements within multifaceted and multidimensional microcosmic techniques, designs, systems, routines, devices, manners, modes, fashions, forms, formats, factors, objects, parts, segments, elements, components, constituents, ingredients, processes, methods and combinations wherefrom hereto entailing, encompassing, comprising, involving, impacting and/or effecting streamlined, alternating scale, inseparable, seamless and natural wrapping, interlacing, coiling, coupling, combining and interlocking proprietary multiport revolving chambered hunting metallic track encasing hermetic cast casing constrained new end-user graphical human interface syntactic synthesis real-time software programs block, proprietary multiport revolving chambered hunting metallic track encasing hermetic cast casing constrained new algebraic problem-solving application syntactic synthesis real-time software programs block, proprietary multiport revolving chambered hunting metallic track encasing hermetic cast casing constrained new robotizing tracking meter systems syntactic synthesis real-time software programs block, proprietary multiport revolving chambered hunting metallic track encasing hermetic cast casing constrained new commerce and transactional exchange methods syntactic synthesis real-time software programs block, and proprietary multiport revolving chambered hunting metallic track encasing hermetic cast casing constrained new commerce and exchange language combinatorial syntactic synthesis real-time software programs block, all proprietary creative original conceptions, engineering utilities, aesthetic architectural designs, authentic compositions, and genuine productions wherefrom herewith concretizing consummate and constructive reduction to practice as a complete sub-loculated cyclical commutative rhombus robotizing real-time microprocessor machine language logic instructing compact integrated new software generator AND-OR closed-circuitry microprocessor engine machine language operating system computing block automatizing real-time holistically steady state synchronized ubiquitous continuum universal executive sub-compartment cyclical commutative rhombus robotizing real-time operating microprocessor syntactic synthesis engine computing system microprogramming language logic instructions entailing, encompassing, comprising, involving, impacting and/or effecting every and all one-time programmable read-only memory (PROM) within a proprietary multiport revolving chambered hunting metallic track encasing hermetic cast casing constrained engine block protective controler soundproof housing and fireclay sealed wall casting fireball impervious carriage data link caster dart castings accumulator central processing unit (CPU) concretizing via conducive appendicular microelectronic templates appended, fixed, soldered, mounted, etched, embedded, copied, inscribed and/or contact printed onto every and all heretofore and hereafter mechanical apparatus microcircuit processing computing motherboards intrinsic and integral as comprehensively suitable, generally pertinent and broadly useful within every and all automatizing high-quality holistically steady state heliocentrically synchronizing ubiquitous hunting continuum commutative rhombus robotizing real-time microprocessing protective housing carriage device apparatus wherefrom hereto successfully embroidering unequivocal absolute resolution proprietary revelatory cognizable relativistic relational melioristic logical positivism syntactic synthesis controlling central processing unit (CPU) fixture originating within every and all iota trace element minutia fueling and/or energizing microprocessor semi-conducting chips, whence perpetually propagating, promulgating and proclaiming galactic alternating angle conduit and alternating scale single independent portal proliferation of artificial semi-conducting microcircuit device article propagating traverse via every and all traditonal mechanical friction and/or chemical reaction to fuel and/or energy power via conduit electrical generation and/or electrical battery, wherefrom hereto via every and all advanced electronic locational systematizing geological and/or seismological processes concretizing innovative transcendent insulated ferromagnetic permeability of article internalized upright orthorhombic tentacular boundless roving antennule steady state transmuting metric conversional transistor transfusing receiver of automatizing high-quality holistically steady state heliocentrically synchronizing ubiquitous hunting continuum commutative rhombus electronic spatiotemporal simultaneous traversal of meta-frequency, wavetrain length wave front electromagnetic continuous spectrum transmission metric unit isogenous single independent portal refractory minutia partible iota beta particle trace element pulse signaling transmission concretizing fuel-efficient and energy power origination catalytic conduits via electrogasdynamics, electrogenesis, electrohydraulic, geomagnetic, gyromagnetic, geokinetic and/or thermodynamic transistorized rheostat regulated galactic staple transfusing partible beta particle trace element galactic iota minutia powered gyroscopic axisymmetrical stabilizing self-impetus protective housing hermetic cast software lock up encasing real-time microprocessor utility engineering didactic rubricating identic heliocentric machine language isogloss unicore isomorphic transfiguration operating system software computing block carriage portable rove bearing articles, apparatuses and megastructures; wherefrom concretizing infinitely automatizing real-time holistically steady state synchronized ubiquitous continuum universal executive sub-compartment cyclical parallel redundancy cosmos robotizing real-time accurate, high-quality, never faulting, fully reliable, never failing, simplified and streamlined microprogrammable systematically codified microprocessor machine language logic instructions comprehensively useful within every and all one-time programmable read-only memory (PROM) innovating a novel and unobvious multiport revolving chambered homing binary hunting metallic track encasing hermetic data link caster dart castings constrained engine block protective contactor composite soundproof housing and fireclay sealed wall casting fireball impervious carriage data link caster dart accumulator unicore controlling central processing unit (CPU) originating fixture onto microprocessor semi-conducting chips. Whereas, furthermore directing a reader's preoccupied and prepossessed attention to UCMOST™ drawing(s) below evincing ornamenting structural and architectural design within FIG. 1 is shown a complete imploded view of elements, components, constituents, factors and/or ingredients entailing, encompassing, comprising, involving, impacting and effecting every and all UCMOST™ information technology. Whereas, within FIG. 1 is depicted aforementioned UCMOST™ information technology hermetic functional and operational orthorhombic rhombus plane integrated closed-circuit hardcore microprocessor unit casting block pointer indentifier 101 element block of data link caster dart castings facilitating apostrophe functional and operational protective factor orthorhombic rhombus plane software apostrophe interface pointer indentifier 102 component block which facilitates dynamic simultaneous apostrophe interfacing with across-the-board traversal of breakthrough technological and groundbreaking innovative developments and advancements within multifaceted and multidimensional microcosmic techniques, designs, systems, routines, devices, manners, modes, fashions, forms, formats, factors, objects, parts, segments, elements, components, constituents, ingredients, processes, methods and combinations of applications software programs transcending the historically separate and traditionally exclusive specialty areas of accounting and financing to propagate logically integrated holistic unity cohension thereto concretizing real-time accounting in connection with real-time financing premised on electronic spatiotemporal simultaneous traversal of meta-frequency, wavetrain length wave front electromagnetic continuous spectrum transmission metric unit isogenous single independent portal refractory minutia partible iota beta particle trace element pulse signaling transmission actualizing real-time transporting in connection with real-time receiving; wherefrom hereto entailing, encompassing, comprising, involving, impacting and/or effecting streamlined, alternating scale, inseparable, seamless and natural wrapping, interlacing, coiling, coupling, combining and interlocking proprietary multiport revolving chambered hunting metallic track encasing hermetic cast casing constrained new end-user graphical human interface real-time software programs constituent orthorhombic rhombus plane applications software programs cast pod pointer indentifier 103 constituent block of data link caster dart castings which empowers proprietary multiport revolving chambered hunting metallic track encasing hermetic cast casing constrained new algebraic problem-solving application syntactic synthesis real-time software programs station block; all proprietary multiport revolving chambered hunting metallic track encasing hermetic cast casing constrained new robotizing tracking meter systems syntactic synthesis real-time software programs station sblock; all proprietary multiport revolving chambered hunting metallic track encasing hermetic cast casing constrained new commerce and transactional exchange methods syntactic synthesis real-time software programs station block; all proprietary multiport revolving chambered hunting metallic track encasing hermetic cast casing constrained new commerce and exchange language combinatorial syntactic synthesis real-time software programs station block; wherefrom whereas every and all hereto identified within functional integrated components and exclusively distinctive orthorhombic rhombus plane applications software processing encased program pointer indentifiers: 104; 105; 106; 107; 108; 109; 110; 111; 112; 113; 114; 115; 116; 117; 118; 119; 120; 121; 122; 123; 124; 125; 126; 127; 128; 129; 130; 131; 132; 133; factor stations which secure distinctively separate albeit interlocking apostrophe interface data link caster dart castings involving aforementioned UCMOST™ real-time processing and/or reprocessing via aforementioned UCMOST™ information technologies; whereas, within the ornamenting architectural and structural design within FIG. 1 is ascertained aforementioned UCMOST™ information technology hermetic security factor orthorhombic rhombus plane hardcore operating system encasing block pod 134 ingredient block security apostrophe interface which is a proprietary multiport revolving chambered hunting metallic track encasing hermetic cast casing constrained new engine housing carriage evincing proprietary creative original conceptions, engineering utilities, aesthetic architectural designs, authentic compositions, and genuine productions concretizing consummate and constructive reduction to practice of a complete sub-loculated cyclical commutative rhombus robotizing real-time microprocessor machine language logic instructing compact integrated new software generator AND-OR closed-circuitry microprocessor engine machine language operating system computing block engineered to facilitate automatizing real-time holistically steady state synchronized ubiquitous continuum universal executive sub-compartment cyclical commutative rhombus robotizing real-time operating microprocessor syntactic synthesis engine computing system microprogramming language logic instructions entailing, encompassing, comprising, involving, impacting and/or effecting every and all one-time programmable read-only memory (PROM) via parallel operational dedicated simultaneous serial transport/receive, present/verify, confirm/validate transmission messaging relay connection line interfacing, wherefrom hereto below collectively innate conception, terminological conveyance, indivisible rubrical, syntactic oralformulaic, systematic arrangement, artistic construct, melodious lyrics, denominative literateness and thereat proprietary multiport revolving chambered hunting metallic track encasing hermetic new software lock up cast casing constrained real-time microprocessor engineering machine language unicore operating system software computing block keyhole combinational code heretofore and hereafter apprehends UCMOST™ real-time microprocessor transmission interfacing, proprietary trademark and service mark is exclusive proprietary intellectual property belonging exclusively and unequivocally to Juan Carlos Castro. Wherefrom, moreoever, within FIG. 1 is ascertained visualization of the richly dynamic, heliocentrical unifying and cohesively integrated aforementioned PUBLIC FINANCIALS™ real-time microprocessor transmission interfacing which is comprehensively suitable, generally pertinent and broadly useful useful to every and all exchange embroidering data and/or information receiver real-time input plug data link caster dart castings evincing: high-quality accounting; high-quality reconciling; high-quality reporting; high-quality communicating; high-quality transporting; high-quality energizing; high-quality fueling; high-quality broadcasting; high-quality treasuring; high-quality distributing, high-quality financing; novel and unobvious standalone machine language microprocessing wherefrom whereas data and/or information transmission concretizing real-time output plug data link caster dart castings facilitating every and all, without limitation, aforementioned UCMOST™ real-time processing and/or reprocessing of data and/or information microprocessor transmission interfacing precast within distincitvely separate compartments enabling real-time seamless, self-contained, never faulting and never failing simultaneous peripheral operational data microprocessing selected from the group consisting of propagating all aforementioned efficient UNIVERSAL CAPITAL MARKET™ conceptual aids hereto proclaiming and promulgating traversal of real-time transmission conduits selected from the heretofore traditional and/or hereto advanced level groups consisting of aforementioned efficient UNIVERSAL CAPITAL MARKET™ communications via simultaneously and dynamically leveraging and harnessing the rich microprocessing power within functional constituent and security factor orthorhombic plane sub-compartment parallel central microprocessor sub-unit pointer indentifier element heliocentrical oscilating 135 UCMOST™ CPU; wherefrom and/or simultaneously and dynamically leveraging and harnessing the rich microprocessing power within functional constituent and security factor orthorhombic plane sub-compartment parallel central microprocessor sub-unit pointer indentifier element heliocentrical oscilating 352 UCMOST™ CPU; wherefrom completely and consummately concretizing every and all real-time receiving, real-time distributing, real-time syndicating inclusive of real-time rebroadcasting, real-time redistributing and real-time resyndicating of every and all aforementioned aforementioned PUBLIC FINANCIALS™ instruments therefrom clearly, undeniably, logically, scientifically and intutively deriving and/or driving every and all aforementioned PUBLIC FINANCIALS™ statements from every and all individual members of the aforementioned PUBLIC FINANCIALS™ organizations inclusive of, without limitation, every and all individuals individual members of the aforementioned UNIVERSAL POPULACE™ to realize propagating logically integrated holistic unity cohension thereto whereas concretizing real-time accounting streamlined, alternating scale, inseparable, seamless and naturally wrapped, interlaced, coiled, coupled, combined and interlocked in connection with real-time financing premised on electronic spatiotemporal simultaneous traversal of meta-frequency, wavetrain length wave front electromagnetic continuous spectrum transmission metric unit isogenous single independent portal refractory minutia partible iota beta particle trace element pulse signaling transmission actualizing real-time transporting streamlined, alternating scale, inseparable, seamless and naturally wrapped, interlaced, coiled, coupled, combined and interlocked in connection with real-time receiving. Within FIG. 2, we ascertain a partial exploded view of elements involving UCMOST™ central microprocessor unit redefining aforementioned UCMOST™ information technology hermetic security factor orthorhombic rhombus plane hardcore operating system encasing block pod 134 ingredient block security apostrophe interface inclusive of every and all, without limitation, aforementioned PUBLIC FINANCIALS™ real-time microprocessor transmission interfacing thereto simultaneously and dynamically via leveraging and harnessing the richly proliferous microprocessing powers within functional constituent and security factor orthorhombic plane sub-compartment parallel central microprocessor microprocessor sub-unit pointer indentifier element heliocentrical oscilating 135 UCMOST™ CPU; whereas, inclusive of, without limitation, simultaneously and dynamically via leveraging and harnessing the richly proliferous microprocessing powers within functional constituent and security factor orthorhombic plane sub-compartment parallel central microprocessor sub-unit pointer indentifier element heliocentrical oscilating 352 UCMOST™ CPU; wherefrom evincing every and all, without limitation, streamlined, alternating scale, inseparable, seamless and natural wrapped, interlaced, coiled, coupled, combined and interlocked aforementioned PUBLIC FINANCIALS real-time microprocessor transmission interfacing whichever irrespective of whether occuring, happening and/or transpiring residually and/or occuring, happening and/or transpiring spontaneously thereto concretizing every and all inherent and/or intrinsic aim, letter, nature, breadth, sound, depth, spirit and scope propagating logically integrated holistically dynamic and unifying cohensive commutative operational, administrative, management and functional streamlined, alternating scale, inseparable, seamless and natural wrapped, interlaced, coiled, coupled, combined and interlocked interaction between and among the infinitely separate hereto universal caustic caster encasing sub-casted information systems within aforementioned UCMOST™ central microprocessor unit pointer indentifier element 135 UCMOST™ CPU in instantaneously synchronous automatizing parallel connection with every and all inherent and/or intrinsic aim, letter, nature, breadth, sound, depth, spirit and scope propagating logically integrated holistically dynamic and unifying cohensive commutative operational, administrative, management and functional streamlined, alternating scale, inseparable, seamless and natural wrapped, interlaced, coiled, coupled, combined and interlocked interaction between and among the infinitely separate hereto universal caustic caster encasing sub-casted information systems within aforementioned UCMOST™ central microprocessor unit pointer indentifier element 352 UCMOST™ CPU. Whereas, within FIG. 3 is a visual depiction of an exploded flow chart comprising aforementioned UCMOST™ real-time processing and/or reprocessing of data and/or information microprocessor transmission interfacing with a real-time UCMOST™ accounting information system hermetically isomorphic assize caustic transmuting identic syntactic transnational and/or translunar rubric universal spatiotemporal heliocentrically oscillating pragmatic sanction data link caster pelleting dart encasing composing distincitvely inseperable housing within pointer identifier element 135 UCMOST™ CPU; whereas, thereof is ascertained preoccupying visualized prepossession of the richly dynamic, seamlessly functional, cohesively integrated and heliocentrical unifying aforementioned UCMOST™ real-time processing and/or reprocessing of data and/or information microprocessor transmission interfacing which is comprehensively suitable, generally pertinent and broadly useful to every and all exchange embroidering data and/or information receiver real-time input plug data link caster dart castings evincing: high-quality accounting; high-quality reconciling; high-quality reporting; high-quality communicating; high-quality transporting; high-quality energizing; high-quality fueling; high-quality broadcasting; high-quality treasuring; high-quality distributing; high-quality financing; whereas, a novel and unobvious standalone symbolizing unified machine language real-time microprocessor formalizing data and/or information transmission concretizing real-time output plug data link caster dart castings facilitating every and all, without limitation, aforementioned UCMOST™ real-time processing and/or reprocessing of data and/or information microprocessor transmission interfacing within a standalone accounting information system selected from the group consisting of propagating all conceptual aids hereto proclaiming and promulgating traversal of real-time transmission conduits selected from the heretofore traditional and/or hereto advanced level groups consisting of communications; wherefrom is depicted within FIG. 3 a multitude of standalone naturally rich, never faulting and never failing streamlined engineering utility and embroidered architectural design comprising element, component, constituent, factor and ingredient boosting and/or plugging ionic catalytic hermetic caustic casings entailing, encompassing, comprising, involving, impacting and effecting all prefabricated preparation and/or spontaneously baeysian randomizing occurrences, happenings, happenstances and/or transpirings whereof leveraging a uniquely novel and unobvious composition evincing microelectronic AND/OR closed-circuitry hermetic housing carriage propagating, proclaiming and promulgating syntactic didactic transfiguration synthesis transnational identic transmuting atmospheric and/or translunar rubric pragmatic sanction; hermetically independent, holistically interoperable, heliocentrical object interlocking and inifinitely unified catholicon real-time microprocessor computer plug-compatible panacean caustic caster casing pod keyhole combinational object software code block; wherefrom, UCMOST™ real-time accounting information system. Wherefrom, within FIG. 3 is depicted all of the richly dynamic, comprehensively fused, heliocentrical unifying and cohesively integrated aforementioned PUBLIC FINANCIALS™ real-time microprocessor transmission interfacing among the elements, components, constituents, factors and ingredients therein originating systematically prefix contracted and/or spontaneously prefix randomized data link caster casings from preformatted and/or preselected automatically accessible ledger balance account housing engine carriage comprising aforementioned UCMOST™ real-time accounting information system; whereas, is depicted orthorhombic planes automatizing real-time accounting system data and/or information input receiver pointer indentifiers: 136; 137, 138; 139; 140; element bins comprising holistic heliocentrically legal patent disclosure transfinite heremetic keyway combinational object software code lock up data link caster pelleting dart castings ledger account balances, whereof composing aforementioned UCMOST™ real-time processing and/or reprocessing of data and/or information microprocessor transmission interfacing herein below involving, housing and/or comprising data link caster pelleting dart casings of the following; whereas, is depicted orthorhombic plane consolidating real-time data and/or information accounting input receiver pointer identifier 141 element bin of data link caster dart castings; whereas, is depicted helix whirling bay container automatizing real-time data and/or information accounting system instantaneously simultaneous kick out and/or undo pointer indentifier 142 component folder of data link caster dart castings; whereas, is depicted helix whirling bay container real-time data and/or information accounting system automatizing input spooling mechanism pointer identifier 143 constituent reel of data link caster dart castings; whereas, is depicted orthorhombic plane real-time data and/or information divisional accounting trace chart of accounts pointer indentifier 144 factor drawer of data link caster pelleting dart casings ledger balance accounts; whereas, is depicted orthorhombic plane automatizing real-time data and/or information accounting openorder match book pointer indentifier 145 ingredient bin of data link caster dart castings; whereas, is depicted orthorhombic plane automatizing real-time data and/or information accounting high-quality review station pointer indentifier 146 element shelf of data link caster dart castings; whereas, is depicted orthorhombic plane automatizing real-time data and/or information accounting metric conversion station pointer indentifier 147 component shelf of data link caster dart castings; whereas, is depicted orthorhombic plane automatizing real-time data and/or information master general ledger booking station pointer indentifier 148 constituent bin of data link caster dart castings; whereas furthermore is depicted orthorhombic plane automatizing real-time data and/or information accounting system control station pointer indentifier 149 factor shelf of data link caster dart castings; whereas, is depicted orthorhombic plane real-time data and/or information accounting digital custom feeds control station pointer indentifier 150 ingredient shelf of data link caster dart castings; whereas, is depicted orthorhombic plane real-time data and/or information accounting ledger validation station pointer indentifier 151 element bin of data link caster dart castings; whereas, is depicted orthorhombic plane real-time data and/or information consolidated accounting trace chart of accounts pointer indentifier 152 component drawer of data link caster dart castings; whereas, is depicted helix whirling bay container of real-time data and/or information master ledger history file pointer indentifier 153 constituent pan of data link caster dart castings; whereas, is depicted helix whirling bay container real-time data and/or information accounting master ledger data file pointer identifier 154 factor pan of data link caster dart castings; whereas, is depicted helix whirling bay container real-time data and/or information accounting master ledger statistics file pointer indentifier 155 ingredient pan of data link caster dart castings; whereas, is depicted orthorhombic plane real-time data and/or information accounting system geological spatiotemporal tracking meter pointer indentifier 156 element shelf of data link caster dart castings; whereas, is depicted helix whirling bay container real-time data and/or information accounting ledger geological spatiotemporal history file pointer indentifier 157 component pan of data link caster dart castings; whereas, is depicted helix whirling bay container real-time data and/or information accounting ledger geological spatiotemporal data file pointer indentifier 158 constituent pan of data link caster dart castings; whereas, is depicted helix whirling bay container real-time data and/or information accounting ledger account statistics file pointer indentifier 159 factor pan of data link caster dart castings; whereas, is depicted helix whirling bay container real-time data and/or information accounting ledger geological spatiotemporal correction log pointer indentifier 160 ingredient bin of data link caster dart castings; whereas, is depicted helix whirling bay container real-time data and/or information accounting guidelines database pointer indentifier 161 element cabinet of data link caster dart castings; whereas, is depicted orthorhombic plane automatizing general data and/or information accounting principles database pointer indentifier 162 component drawer of data link caster dart castings; whereas, is depicted orthorhombic plane automatizing general data and/or information accounting concepts database pointer indentifier 163 constituent drawer of data link caster dart castings; whereas, is depicted orthorhombic plane automatizing general data and/or information accounting standards pointer indentifier 164 factor drawer of data link caster dart castings; whereas, is depicted helix whirling bay container real-time data and/or information accounting transnational standards database pointer indentifier 165 ingredient cabinet of data link caster dart castings; whereas, is depicted orthorhombic plane automatizing real-time data and/or information transnational accounting principles pointer indentifier 166 element drawer of data link caster dart castings; whereas, is depicted orthorhombic plane automatizing real-time data and/or information transnational accounting standards pointer indentifier 167 component drawer of data link caster dart castings; whereas, is depicted orthorhombic plane automatizing real-time data and/or information transnational accounting interpretations pointer indentifier 168 constituent drawer of data link caster dart castings; whereas, is depicted helix whirling bay container real-time data and/or information ledger balance reporting standards database pointer indentifier 169 factor cabinet of data link caster dart castings; whereas, is depicted orthorhombic plane automatizing real-time data and/or information standard reporting points bulletins database pointer indentifier 170 ingredient drawer of data link caster dart castings; whereas, is depicted orthorhombic plane automatizing real-time data and/or information standard reporting releases database pointer indentifier 171 element drawer of data link caster dart castings; whereas, is depicted orthorhombic plane automatizing real-time data and/or information standard reporting interpretations database pointer indentifier 172 component drawer of data link caster dart castings; whereas, is depicted helix whirling bay container real-time data and/or information transnational reporting standards database pointer indentifier 173 constituent cabinet of data link caster dart castings; whereas, is depicted orthorhombic plane automatizing real-time data and/or information transnational accounting releases database pointer indentifier 174 factor drawer of data link caster dart castings; whereas, is depicted orthorhombic plane automatizing real-time data and/or information transnational accounting statements database pointer indentifier 175 ingredient drawer of data link caster dart castings; whereas, is depicted orthorhombic plane automatizing real-time data and/or information transnational accounting interpretations database pointer indentifier 176 element drawer of data link caster dart castings; whereas, is depicted helix whirling bay container real-time data and/or information accounting governmental standards database pointer indentifier 177 component cabinet of data link caster dart castings; whereas, is depicted orthorhombic plane automatizing real-time data and/or information governmental accounting principles database pointer indentifier 178 constituent drawer of data link caster dart castings; whereas, is depicted orthorhombic plane automatizing real-time data and/or information governmental accounting standards database pointer indentifier 179 factor drawer of data link caster dart castings; whereas, is depicted orthorhombic plane automatizing real-time data and/or information governmental accounting interpretations database pointer indentifier 180 ingredient drawer of data link caster dart castings; whereas, is depicted helix whirling bay container real-time transnational auditing standards database pointer indentifier 181 component cabinet of data link caster dart castings; whereas, is depicted orthorhombic plane automatizing real-time data and/or information transnational auditing standards database pointer indentifier 182 constituent drawer of data link caster dart castings; whereas, is depicted orthorhombic plane automatizing real-time data and/or information transnational auditing interpretations database pointer indentifier 183 factor drawer of data link caster dart castings; whereas, is depicted orthorhombic plane automatizing real-time data and/or information general transnational auditing practices database pointer indentifier 184 ingredient drawer of data link caster dart castings; whereas, is depicted orthorhombic plane automatizing real-time data and/or information accounting data and/or information transmitting output pointer indentifier 185 element bin of data link caster dart castings; whereas, is depicted helix whirling bay container real-time data accounting transmission history file storage pointer indentifier 186 component pan of data link caster dart castings; whereas, is depicted helix whirling bay container real-time information accounting transmission history file storage pointer indentifier 187 constituent pan of data link caster dart castings; whereas, is depicted helix bay charactery, numerc, voice, video and/or image transmission storage pointer indentifier 188 factor pan of data link caster dart castings; whereas, is depicted helix whirling bay container real-time data, information, charactery, numeric, voice, video and/or image transmission log pointer indentifier 189 ingredient pan of data link caster dart castings; whereas, is depicted orthorhombic plane real-time data, information, charactery, numeric, voice, video and/or image transmission recovery pointer indentifier 190 ingredient pan of data link caster pelleting dart casings. Whereas, within FIG. 4 is depicted an exploded flow chart comprising aforementioned UCMOST™ real-time processing and/or reprocessing of data and/or information microprocessor transmission interfacing with a real-time UCMOST™ reconciling information system hermetically isomorphic assize caustic transmuting identic syntactic transnational and/or translunar rubric universal spatiotemporal heliocentrically oscillating pragmatic sanction data link caster pelleting dart encasing composing distincitvely inseperable housing within pointer indentifier element 135 UCMOST™ CPU; whereas, thereof is ascertained preoccupying visualized prepossession of the richly dynamic, seamlessly functional, cohesively integrated and heliocentrical unifying aforementioned UCMOST™ real-time processing and/or reprocessing of data and/or information microprocessor transmission interfacing which is comprehensively suitable, generally pertinent and broadly useful to every and all exchange embroidering data and/or information receiver real-time input plug data link caster dart castings evincing: high-quality accounting; high-quality reconciling; highquality reporting; high-quality communicating; high-quality transporting; high-quality energizing; high-quality fueling; high-quality broadcasting; high-quality treasuring; high-qulihty distributing; high-quality financing; whereas, a novel and unobvious standalone symbolizing unified machine language real-time microprocessor formalizing data and/or information transmission concretizing real-time output plug data link caster dart castings facilitating every and all, without limitation, aforementioned UCMOST™ real-time processing and/or reprocessing of data and/or information microprocessor transmission interfacing within a standalone transporting data and/or information system selected from the group consisting of propagating all conceptual aids hereto proclaiming and promulgating traversal of real-time transmission conduits selected from the heretofore traditional and/or hereto advanced level groups consisting of communications; wherefrom is depicted within FIG. 4 a multitude of standalone naturally rich, never faulting and never failing streamlined engineering utility and embroidered architectural design comprising element, component, constituent, factor and ingredient boosting whereas plugging ionic catalytic hermetic caustic casings entailing, encompassing, comprising, involving, impacting and effecting all prefabricated preparation and/or spontaneously baeysian randomizing occurrences, happenings, happenstances and/or transpirings; whereof, harnessing and leveraging a uniquely novel and unobvious composition evincing microelectronic AND/OR closed-circuitry hermetic soundproof housing and fireclay sealed wall casting fireball impervious engine carriage propagating, proclaiming and promulgating syntactic didactic transfiguration synthesis transnational identic transmuting atmospheric and/or translunar rubric pragmatic sanction; hermetically independent, holistically interoperable, heliocentrical object interlocking and inifinitely unified catholicon real-time microprocessor computer plug-compatible panacean caustic caster casing pod keyhole combinational object software code block; wherefrom, UCMOST™ real-time reconciling information system. Whereas within FIG. 4 is depicted all of the richly dynamic, comprehensively fused, heliocentrical unifying and cohesively integrated aforementioned PUBLIC FINANCIALS™ real-time microprocessor transmission interfacing among the elements, components, constituents, factors and ingredients therein originating systematically prefix contracted and/or spontaneously prefix randomized data link caster casings from preformatted and/or preselected automatically accessible ledger balance account housing engine carriage comprising aforementioned UCMOST™ real-time reconciling information system; whereas, is depicted orthorhombic plane automatizing real-time reconciling system data and/or information input receiver pointer indentifier 191 element bin comprising holistic heliocentrically legal patent disclosure transfinite heremetic keyway combinational object software code lock up data link caster pelleting dart castings ledger account balances, whereof composing aforementioned UCMOST™ real-time processing and/or reprocessing of data and/or information microprocessor transmission interfacing herein below involving, housing andJor comprisng data link caster pelleting dart casings of the following; whereas, is depicted orthorhombic plane automatizing real-time data and/or information reconciling metric conversion station pointer indentifier 192 component shelf of data link caster dart castings; whereas, is depicted orthorhombic plane automatizing real-time data and/or information reconciling high-quality review station pointer indentifier 193 constituent shelf of data link caster dart castings; whereas, is depicted orthorhombic plane automatizing real-time data and/or information reconciling system control station pointer 194 factor shelf of data link caster dart castings; whereas, is depicted helix whirling bay container automatizing real-time data and/or information reconciling correction log pointer indentifier 195 ingredient bin of data link caster dart castings; whereas, is depicted orthorhombic plane real-time data and/or information automatizing reconciling open-order match book pointer indentifier 196 element bin of data link caster dart castings; whereas, is depicted helix whirling bay container automatizing real-time data and/or information reconciling system instantaneously simultaneous kick out and/or undo pointer indentifier 197 component folder of data link caster dart castings; whereas, is depicted helix whirling bay container automatizing real-time data and/or information reconciling system automatizing input spooling mechanism pointer indentifier 198 constituent reel of data link caster dart castings; whereas, is depicted orthorhombic plane real-time data and/or information reconciling spatiotemporal tracking meter pointer 199 factor shelf of data link caster dart castings; whereas, is depicted orthorhombic plane real-time data and/or information reconciling custom control station pointer indentifier 200 ingredient shelf of data link caster dart castings; whereas, is depicted helix whirling bay container real-time data and/or information reconciling system matching station pointer indentifier 201 element pan of data link caster dart castings; whereas, is depicted helix whirling bay container real-time data and/or information reconciling system clearing station pointer indentifier 202 component pan of data link caster dart castings; whereas, is depicted helix whirling bay container real-time data and/or information reconciling system executing station pointer identifier 203 constituent pan of data link caster dart castings; whereas, is depicted helix whirling bay container real-time data and/or information reconciling system settling station pointer identifier 204 factor pan of data link caster dart castings; whereas, is depicted helix whirling bay container real-time data and/or information reconciling system exchanging station pointer identifier 205 ingredient pan of data link caster dart castings; whereas, is depicted orthorhombic plane automatizing real-time data and/or information reconciling validation station pointer identifier 206 element bin of data link caster dart castings; whereas, is depicted helix whirling bay container real-time open-order data and/or information reconciling history file storage pointer identifier 207 component folder of data link caster dart castings; whereas, is depicted helix whirling bay container real-time open-order data and/or information reconciling file storage pointer identifier 208 constituent folder of data link caster dart castings; whereas, is depicted helix whirling bay container real-time open-order data and/or information reconciling statistics storage pointer identifier 209 factor folder of data link caster dart castings; whereas, is depicted helix whirling bay container real-time validation data and/or information reconciling history file storage pointer identifier 210 ingredient bin of data link caster dart castings; whereas, is depicted helix whirling bay container real-time validation data and/or information reconciling file storage pointer identifier 211 element folder of data link caster dart castings; whereas, is depicted helix whirling bay container real-time validation data and/or information reconciling statistics storage pointer identifier 212 component folder of data link caster dart castings; whereas, is depicted helix whirling bay data and/or information container treasures, retained earnings, equity and participation interests pointer identifier 213 constituent pan of data link caster dart castings; whereas, is depicted helix whirling bay data and/or information container of cash equivalents, receivables, allowances and/or deferrals pointer identifier 214 factor pan of data link caster dart castings; whereas, is depicted helix whirling bay data and/or information container of master inventory and master pricing lists pointer identifier 215 ingredient pan of data link caster dart castings; whereas, is depicted helix bay data and/or information container of property, casualty, life, health, disability, vision and dental contracts and/or policies pointer identifier 216 element pan of data link caster dart castings; whereas, is depicted helix whirling bay data and/or information container of extraordinary items, intangible goodwill, deferred taxes, discontinued segment operations pointer identifier 217 component pan of data link caster dart castings; whereas, is depicted helix whirling bay data and/or information container of variable derivatives, treasure payable and long-term treasure obligations pointer identifier 218 constituent pan of data link caster dart castings; whereas, is depicted helix whirling bay data and/or information container of property, plant and equipment, depreciation and amortization plans and schedules pointer identifier 219 factor pan of data link caster dart castings; whereas, is depicted helix whirling bay data and/or information container of cost of goods sold and real-time cost allocation plans and schedules pointer identifier 220 ingredient pan of data link caster dart castings; whereas, is depicted helix whirling bay data and/or information container of operating labor expense and real-time cost allocations plans and schedules pointer identifier 221 element pan of data link caster dart castings; whereas, is depicted helix whirling bay data and/or information container of revenues net general administration, operating leases, research and development pointer identifier 222 component pan of data link caster dart castings; whereas, is depicted helix whirling bay data and/or information container of payroll, taxes and work compensation assures, pension and deferred plan obligations pointer identifier 223 constituent pan of data link caster dart castings; whereas, is depicted helix whirling bay data and/or information container of ledger accounts payable, treasure financings, discounts and accruals pointer identifier 224 factor pan of data link caster dart castings; whereas, is depicted orthorhombic plane real-time open-order data and/or information reconciling transmission output pointer identifier 225 ingredient pan of data link caster dart castings; whereas, is depicted helix whirling bay container real-time open-order data reconciling transmission history file storage pointer identifier 226 element bin of data link caster dart castings; whereas, is depicted helix whirling bay container real-time open-order information reconciling transmission history file storage pointer identifier 227 component bin of data link caster dart castings; whereas, is depicted helix whirling bay container real-time open-order data, information, character, numeric, audio, voice, sound, video, post, copy, graphic, design, figure, object, picture and/or image transmission storage pointer identifier 228 constituent bin of data link caster dart castings; whereas, is depicted helix whirling bay container real-time open-order data, information, character, numeric, audio, voice, sound, video, post, copy, graphic, design, figure, object, picture and/or image transmission log pointer identifier 229 factor bin of data link caster dart castings; whereas, is depicted orthorhombic plane real-time open-order data, information, character, numeric, audio, voice, sound, video, post, copy, graphic, design, figure, object, picture and/or image transmission recovery pointer identifier 230 ingredient bin of data link caster dart castings; whereas, is depicted orthorhombic plane real-time validated data and/or information reconciling transmission output pointer identifier 231 element bin of data link caster dart castings; whereas, is depicted helix whirling bay container real-time validated data reconciling transmission file storage pointer identifier 232 component bin of data link caster dart castings; whereas, is depicted helix whirling bay container real-time validated information reconciling transmission history file storage pointer identifier 233 constituent bin of data link caster dart castings; whereas, is depicted helix bay validated character, numeric audio, voice, video and image transmission storage pointer identifier 234 factor bin of data link caster dart castings; whereas, is depicted helix whirling bay container data, information, character, numeric, audio, voice, video and image transmission log pointer identifier 235 ingredient bin data link caster dart castings; whereas, is depicted orthorhombic plane data, information, character, numeric, audio, voice, video and image transmission recovery pointer identifier 236 element bin of data link caster dart castings. Whereas, within FIG. 5 is depicted an exploded flow chart comprising aforementioned UCMOST™ real-time processing and/or reprocessing of data and/or information microprocessor transmission interfacing with a real-time UCMOST™ reporting information system hermetically isomorphic assize caustic transmuting identic syntactic transnational and/or translunar rubric universal spatiotemporal heliocentrically oscillating pragmatic sanction data link caster pelleting dart encasing composing distincitvely inseperable housing within pointer indentifier element 135 UCMOST™ CPU; whereas, thereof is ascertained preoccupying visualized prepossession of the richly dynamic, seamlessly functional, cohesively integrated and heliocentrical unifying aforementioned UCMOST™ real-time processing and/or reprocessing of data and/or information microprocessor transmission interfacing which is comprehensively suitable, generally pertinent and broadly useful to every and all transactional exchange embroidering aforementioned input plug data link caster dart castings evincing: high-quality accounting; high-quality reconciling; high-quality reporting; high-quality communicating; high-quality transporting; high-quality energizing; high-quality fueling; high-quality broadcasting; high-quality treasuring; high-quality distributing; high-quality financing; whereas, a novel and unobvious standalone symbolizing unified machine language real-time microprocessor formalizing data and/or information transmission concretizing real-time output plug data link caster dart castings facilitating every and all, without limitation, aforementioned UCMOST™ real-time processing and/or reprocessing of data and/or information microprocessor transmission interfacing within a standalone reporting information system selected from the group consisting of propagating all conceptual aids hereto proclaiming and promulgating traversal of real-time transmission conduits selected from the heretofore traditional and/or hereto advanced level groups consisting of communications; wherefrom is depicted within FIG. 5 a multitude of standalone naturally rich, never faulting and never failing streamlined engineering utility and embroidered architectural design comprising element, component, constituent, factor and ingredient boosting whereas plugging ionic catalytic hermetic caustic casings entalling, encompassing, comprising, involving, impacting and effecting all prefabricated preparation and/or spontaneously baeysian randomizing occurrences, happenings, happenstances and/or transpirings; whereof, harnessing and leveraging a uniquely novel and unobvious composition evincing microelectronic AND/OR closed-circuitry hermetic soundproof housing and fireclay sealed wall casting fireball impervious engine carriage propagating, proclaiming and promulgating syntactic didactic transfiguration synthesis transnational identic transmuting atmospheric and/or translunar rubric pragmatic sanction; hermetically independent, holistically interoperable, heliocentrical object interlocking and inifinitely unified catholicon real-time microprocessor computer plug-compatible panacean caustic caster casing pod keyhole combinational object software code block; wherefrom, UCMOST™ real-time reporting information system. Whereas, within FIG. 5 is depicted all of the richly dynamic, comprehensively fused, heliocentrical unifying and cohesively integrated aforementioned PUBLIC FINANCIALS™ real-time microprocessor transmission interfacing among the elements, components, constituents, factors and ingredients therein originating systematically prefix contracted and/or spontaneously prefix randomized data link caster casings from preformatted and/or preselected automatically accessible ledger balance account housing engine carriage comprising aforementioned UCMOST™ real-time reporting information system; whereas, is depicted orthorhombic plane automatizing real-time reporting system data and/or information input receiver pointer indentifier 237 element bin comprising holistic heliocentrically legal patent disclosure transfinite heremetic keyway combinational object software code lock up data link caster pelleting dart castings ledger account balances, whereof composing aforementioned UCMOST™ real-time processing and/or reprocessing of data and/or information microprocessor transmission interfacing herein below involving, housing and/or comprising data link caster pelleting dart casings of the following; whereas, is depicted helix whirling bay container automatizing data and/or information reporting kick out/undo pointer identifier 238 component folder of data link caster dart castings; whereas, is depicted helix whirling bay container real-time data and/or information reporting automatizing input spooling mechanism pointer identifier 239 constituent reel of data link caster dart castings; whereas, is depicted orthorhombic plane automatizing real-time data and/or information reporting order metric conversion station pointer identifier 240 factor shelf of data link caster dart castings; whereas, is depicted orthorhombic plane automatizing real-time data and/or information reporting high-quality review station pointer identifier 241 ingredient shelf of data link caster dart castings; whereas, is depicted orthorhombic plane automatizing real-time data and/or information reporting system control station pointer identifier 242 element shelf of data link caster dart castings; whereas, is depicted helix whirling bay container automatizing real-time data and/or information reporting correction log pointer identifier 243 component bin of data link caster dart castings; whereas, is depicted orthorhombic plane real-time spatiotemporal data and/or information reporting tracking meter pointer identifier 244 constituent shelf of data link caster dart castings; whereas, is depicted orthorhombic plane real-time data and/or information reporting custom control station pointer identifier 245 factor shelf of data link caster dart castings; whereas, is depicted orthorhombic plane automatizing real-time data and/or information reporting open-order match book pointer identifier 246 ingredient bin of data link caster dart castings; whereas, is depicted helix whirling bay data and/or information container real-time reporting methods, guides and standards database pointer identifier 247 element cabinet of data link caster dart castings; whereas, is depicted orthorhombic plane data and/or information automatizing real-time principles of financing database pointer identifier 248 component drawer of data link caster dart castings; whereas, is depicted orthorhombic plane data and/or information automatizing real-time valuation of currency database pointer identifier 249 constituent drawer of data link caster dart castings; whereas, is depicted orthorhombic plane data and/or information automatizing real-time equity instrument valuation database pointer identifier 250 factor drawer of data link caster dart castings; whereas, is depicted orthorhombic plane data and/or information automatizing real-time instrument management database pointer identifier 251 ingredient drawer of data link caster dart castings; whereas, is depicted orthorhombic plane data and/or information automatizing real-time standards, principles, ethics, morals, values, norms, ways, mores, objectives and conditions database pointer identifier 252 element drawer of data link caster dart castings; whereas, is depicted orthorhombic plane data and/or information automatizing real-time econometric costbenefit analysis database pointer identifier 253 component drawer of data link caster cast casings; whereas, is depicted orthorhombic plane data and/or information automatizing real-time treasure obligation valuation database pointer identifier 254 constituent drawer of data link caster dart castings; whereas, is depicted orthorhombic plane data and/or information automatizing real-time quantitative methodologies database pointer identifier 255 factor drawer of data link caster dart castings; whereas, is depicted helix whirling bay data and/or information container real-time accounting, transporting, reporting and auditing database pointer identifier 256 ingredient cabinet of data link caster dart castings; whereas, is depicted orthorhombic plane data and/or information automatizing real-time derivative options contracts database pointer identifier 257 element drawer of data link caster dart castings; whereas, is depicted orthorhombic plane automatizing real-time accounting, transporting, auditing and reporting database pointer identifier 258 component drawer of data link caster dart castings; whereas, is depicted orthorhombic plane data and/or information automatizing real-time domestic and transnational tax account database pointer identifier 259 constituent drawer of data link caster dart castings; whereas, is depicted orthorhombic plane data and/or information automatizing real-time management accounting database pointer identifier 260 factor drawer of data link caster dart castings; whereas, is depicted orthorhombic plane automatizing real-time independent accounting, transporting, reporting and auditing special reports database pointer identifier 261 ingredient drawer of data link caster dart castings; whereas, is depicted orthorhombic plane data and/or information automatizing real-time activity-based cost accounting database pointer identifier 262 element drawer of data link caster dart castings; whereas, is depicted orthorhombic plane automatizing real-time data and/or information entitlement benefits accounting, transporting, reporting and auditing database pointer identifier 263 component drawer of data link caster dart castings; whereas, is depicted orthorhombic plane automatizing real-time data and/or information inclusive of heretofore superannuated information systems microprogramming languages and software programs accounting database pointer identifier 264 constituent drawer of data link caster dart castings; whereas, is depicted helix bay real-time governmnet and/or organizational accounting, transporting, reporting and auditing database pointer identifier 265 factor cabinet of data link caster dart castings; whereas, is depicted orthorhombic plane data and/or information automatizing real-time audit standards and controls database pointer identifier 266 ingredient drawer of data link caster dart castings; whereas, is depicted orthorhombic plane data and/or information automatizing real-time capital resource budget allocations database pointer identifier 267 element drawer of data link caster dart castings; whereas, is depicted orthorhombic plane data and/or information automatizing real-time performance measurement database pointer identifier 268 component drawer of data link caster dart castings; whereas, is depicted orthorhombic plane data and/or information automatizing real-time standards, principles, ethics, moral, values, norms, mores, ways, objectives and condtions database pointer identifier 269 constituent drawer of data link caster dart castings; whereas, is depicted orthorhombic plane data and/or information automatizing real-time accounting, transporting, reporting and auditing database pointer identifier 270 factor drawer of data link caster dart castings; whereas, is depicted orthorhombic plane data and/or information automatizing real-time activity-based cost accounting database pointer identifier 271 ingredient drawer of data link caster dart castings; whereas, is depicted helix whirling bay data and/or information container bi-camerals, not-for-profits, schools, universities, hospitals, day-care centers, youth centers, parks, recreation centers, sporting arenas and entertainment arena and/or complexes accounting, transporting, reporting and auditing database pointer identifier 272 element cabinet of data link caster dart castings; whereas, is depicted orthorhombic plane data and/or information automatizing real-time internal treasure service funds database pointer identifier 273 component drawer of data link caster dart castings; whereas, is depicted orthorhombic plane data and/or information automatizing real-time organizational general funds database pointer identifier 274 constituent drawer of data link caster dart castings; whereas, is depicted orthorhombic plane data and/or information automatizing real-time treasure obligation service funds database pointer identifier 275 factor drawer of data link caster dart castings; whereas, is depicted orthorhombic plane data and/or information automatizing real-time enterprise development database pointer identifier 276 ingredient drawer of data link caster dart castings; whereas, is depicted orthorhombic plane data and/or information automatizing real-time organizational special revenues database pointer identifier 277 element drawer of data link caster dart castings; whereas, is depicted orthorhombic plane data and/or information automatizing real-time work projects capital database pointer identifier 278 component drawer of data link caster dart castings; whereas, is depicted helix bay data and/or information container domestic and/or transnatonal real-time accounting, transporting, reporting and auditing standards, practices, methods, interpretations database pointer identifier 279 constituent cabinet of data link caster dart castings; whereas, is depicted orthorhombic plane data and/or information automatizing real-time accounting, transporting, reporting and auditing principles database pointer identifier 280 factor drawer of data link caster dart castings; whereas, is depicted orthorhombic plane data and/or information automatizing real-time accounting, transporting, reporting and auditing standards database pointer identifier 281 ingredient drawer of data link caster dart castings; whereas, is depicted orthorhombic plane data and/or information automatizing real-time accounting, transporting, reporting and auditing interpretations database pointer identifier 282 element drawer of data link caster dart castings; whereas, is depicted orthorhombic plane data and/or information automatizing real-time accounting, transporting, reporting and auditing practices database pointer identifier 283 component drawer of data link caster dart castings; whereas, is depicted orthorhombic plane data and/or information automatizing real-time accounting, transporting, reporting and auditing ethics database pointer identifier 284 constituent drawer of data link caster dart castings; whereas, is depicted orthorhombic plane data and/or information automatizing real-time accounting, transporting, reporting and auditing conduct rules database pointer identifier 285 factor drawer of data link caster dart castings; whereas, is depicted orthorhombic plane data and/or information automatizing real-time accounting, transporting, reporting and auditing factou anaygis database pointer identifier 286 ingredient drawer of data link caster dart castings; whereas, is depicted orthorhombic plane data and/or information automatizing real-time accounting, transporting, reporting and auditing procedures database pointer identifier 287 element drawer of data link caster dart castings; whereas, is depicted helix whirling bay data and/or information container presidential, congress and judicial legal history files database pointer identer 299 component cabinet of data link caster dart eigtings, whereas, is depicted orthorhombic plane data and/or information automatizing u.s. presidential and congress legislative branch database pointer identifier 289 constituent drawer of data link caster dart castings; whereas, is depicted orthorhombic plane data and/or information automatizing u.s. securities act of 1933 database pointer identifier 290 factor drawer of data link caster dart castings; whereas, is depicted orthorhombic plane data and/or information automatizing u.s. securities act of 1933 rules database pointer identifier 291 ingredient drawer of data link caster dart castings; whereas, is depicted orthorhombic plane data and/or information automatizing u.s. securities act of 1933 releases database pointer identifier 292 element drawer of data link caster dart castings; whereas, is depicted orthorhombic plane data and/or information automatizing u.s. securities division of corporate regulatory database pointer identifier 293 component drawer of data link caster dart castings; whereas, is depicted orthorhombic plane data and/or information automatizing u.s. supreme court judicial branch database pointer identifier 294 constituent drawer of data link caster dart castings; whereas, is depicted orthorhombic plane data and/or information automatizing u.s. securities exchange act of 1934 database pointer identifier 295 factor drawer of data link caster dart castings; whereas, is depicted orthorhombic plane data and/or information automatizing u.s. securities exchange act of 1934 rules database pointer identifier 296 ingredient drawer of data link caster dart castings; whereas, is depicted orthorhombic plane data and/or information automatizing u.s. securities exchange act of 1934 releases database pointer identifier 297 element drawer of data link caster dart castings; whereas, is depicted orthorhombic plane data and/or information automatizing u.s. securities division of corporate finance database pointer identifier 298 component drawer of data link caster dart castings; whereas, is depicted helix whirling bay data and/or information container u.s. securities act and/or u.s. securities exchange act regulatory history files database pointer identifier 299 constituent cabinet of data link caster dart castings; whereas, is depicted orthorhombic plane data and/or information automatizing u.s. securities division of market reglation database pointer identifier 300 factor drawer of data link caster dat castings; whereas, is depicted orthorhombic plane data and/or information automatizing u.s. securities history investigations database pointer identifier 301 ingredient drawer of data link caster dart castings; whereas, is depicted orthorhombic plane data and/or information automatizing u.s. securities act of 1933 guidelines database pointer identifier 302 element drawer of data link caster dart castings; whereas, is depicted orthorhombic plane data and/or information automatizing u.s. securities act of 1933 filing forms database pointer identifier 303 component drawer of data link caster dart castings; whereas, is depicted orthorhombic plane data and/or information automatizing u.s. securities div. of instrument regulation database pointer identifier 304 constituent drawer of data link caster dart castings; whereas, is depicted orthorhombic plane data and/or information automatizing u.s. securities div. of market enforcement database pointer identifier 305 factor drawer of data link caster dart castings; whereas, is depicted orthorhombic plane data and/or information automatizing u.s. exchange act of 1934 guidelines database pointer identifier 306 ingredient drawer of data link caster dart castings; whereas, is depicted orthorhombic plane data and/or information automatizing u.s. exchange act of 1934 filing forms database pointer identifier 307 element drawer of data link caster dart castings; whereas, is depicted helix whirling bay data and/or information container domestic and/or transnational real-time accounting, reconciling, reporting database pointer identifier 308 component cabinet of data link caster dart castings; whereas, is depicted orthorhombic plane data and/or information automatizing real-time u.s. sec. regulation s-x database pointer identifier 309 constituent drawer of data link caster dart castings; whereas, is depicted orthorhombic plane data and/or information automatizing accounting, reconciling, reporting irregularities database pointer identifier 310 factor drawer of data link caster dart castings; whereas, is depicted orthorhombic plane data and/or information automatizing accounting, reconciling, reporting guidelines database pointer identifier 311 ingredient drawer of data link caster dart castings; whereas, is depicted orthorhombic plane data and/or information automatizing audits and/or investigations guidelines database pointer identifier 312 element drawer of data link caster dart castings; whereas, is depicted orthorhombic plane data and/or information automatizing accounting, reconciling, reporting releases database pointer identifier 313 component drawer of data link caster dart castings; whereas, is depicted orthorhombic plane data and/or information automatizing real-time u.s. sec. regulation s-k database pointer identifier 314 constituent drawer of data link caster dart castings; whereas, is depicted orthorhombic plane data and/or information automatizing administrative real-time writ of subpoena, discovery, deposition, temporary and/or permanent injunction court orders database pointer identifier 315 factor drawer of data link caster dart castings; whereas, is depicted orthorhombic plane data and/or information automatizing real-time writ of prohibition, sequestration and/or ceast-and-desist court orders database pointer identifier 316 ingredient drawer of data link caster dart castings; whereas, is depicted orthorhombic plane data and/or information automatizing real-time civil and/or criminal adjudication court orders database pointer identifier 317 element drawer of data link caster dart castings; whereas, is depicted orthorhombic plane data and/or information automatizing real-time civil fines and/or punitive damage awards database pointer identifier 318 constituent drawer of data link caster dart castings; whereas, is depicted helix bay data and/or information container real-time national and/or transnational accounting, transporting, reporting and auditing board database pointer identifier 319 factor cabinet of data link caster dart castings; whereas, is depicted orthorhombic plane data and/or information automatizing real-time board authoritative statements database pointer identifier 320 ingredient drawer of data link caster dart castings; whereas, is depicted orthorhombic plane data and/or information automatizing real-time accounting, transporting, reporting and auditing board bulletin pronouncements database pointer identifier 321 element drawer of data link caster dart castings; whereas, is depicted orthorhombic plane data and/or information automatizing real-time accounting, transporting, reporting and auditing board methods and ethics database pointer identifier 322 component drawer of data link caster dart castings, whereas, is depicted orthorhombic plane data and/or information automatizing real-time accounting, transporting, reporting and auditing board rubric interpretations database pointer identifier 323 constituent drawer of data link caster dart castings; whereas, is depicted helix whirling bay real-time data and/or information container independent intermediary rubric pragmatic sanction pointer identifier 324 factor cabinet of data link caster dart castings; whereas, is depicted orthorhombic plane data and/or information automatizing u.s. central real-time policy statements database pointer identifier 325 ingredient drawer of data link caster dart castings; whereas, is depicted orthorhombic plane data and/or information automatizing u.s. central real-time matching, clearing, executing, settling and exchanging database pointer identifier 326 element drawer of data link caster dart castings; whereas, is depicted orthorhombic plane data and/or information automatizing u.s. central intermediary board transcripts database pointer identifier 327 component drawer of data link caster dart castings; whereas, is depicted orthorhombic plane data and/or information automatizing u.s. central intermediary board facts analysis database pointer identifier 328 constituent drawer of data link caster dart castings; whereas, is depicted orthorhombic plane data and/or information automatizing u.s. intermediary accounting requisites database pointer identifier 329 factor drawer of data link caster dart castings; whereas, is depicted orthorhombic plane data and/or information automatizing u.s. intermediary reporting requisites database pointer identifier 330 ingredient drawer of data link caster dart castings; whereas, is depicted orthorhombic plane data and/or information automatizing u.s. long-term monetary policies database pointer identifier 331 element drawer of data link caster dart castings; whereas, is depicted orthorhombic plane data and/or information automatizing u.s. long-term economic policies database pointer identifier 332 component drawer of data link caster dart castings; whereas, is depicted helix whirling bay container real-time open-order data and/or information reporting file storage pointer identifier 333 constituent pan of data link caster dart castings; whereas, is depicted helix whirling bay container real-time open-order data and/or information reporting history file storage pointer identifier 334 factor pan of data link caster dart castings; whereas, is depicted helix whirling bay container real-time open-order data and/or information reporting statistics storage pointer identifier 335 ingredient pan of data link caster dart castings; whereas, is depicted orthorhombic plane real-time open-order data and/or information reporting transmission output pointer identifier 336 element bin of data link caster dart castings; whereas, is depicted helix whirling bay container real-time open-order reporting data transmission file storage pointer identifier 337 component pan of data link caster dart castings; whereas, is depicted helix whirling bay container real-time open-order information transmission history file storage pointer identifier 338 constituent pan of data link caster dart castings; whereas, is depicted helix bay open-order character, numeric, audio, voice, video and image transmission storage pointer identifier 339 factor pan of data link caster dart castings; whereas, is depicted helix whirling bay container data, information, character, numeric, audio, voice, sound, video, post, copy, graphic, design, figure, object, picture and/or image transmission log pointer identifier 340 ingredient bin of data link caster dart castings; whereas, is depicted orthorhombic plane data, information, character, numeric, audio, voice, sound, video, graphic, picture and/or image transmission recovery pointer identifier 341 element bin of data link caster dart castings; whereas, is depicted orthorhombic plane real-time validating data and/or information reporting station pointer identifier 342 component shelf of data link caster dart castings; whereas, is depicted helix whirling bay container real-time validating data and/or information reporting file storage pointer identifier 343 constituent pan of data link caster dart castings; whereas, is depicted helix whirling bay container real-time validating data and/or information reporting history file storage pointer identifier 344 factor pan of data link caster dart castings; whereas, is depicted helix whirling bay container real-time validating data and/or information reporting statistics storage pointer identifier 345 ingredient pan of data link caster dart castings; whereas, is depicted orthorhombic plane real-time validating data and/or information reporting transmission output pointer identifier 346 element bin of data link caster dart castings; whereas, is depicted helix whirling bay container real-time validated data reporting transmission file storage pointer identifier 347 component pan of data link caster dart castings; whereas, is depicted helix whirling bay container real-time validated information repoting transmission history file storage pointer identifier 348 constituent pan of data link caster dart castings; whereas, is depicted helix bay validated data, information, character, numeric, audio, voice, sound, video, post, copy, graphic, design, figure, object, picture and/or image transmission storage pointer identifier 349 factor pan of data link caster dart castings; whereas, is depicted helix whirling bay container data, information, character, numeric, audio, voice, sound, video, post, copy, graphic, design, figure, object, picture and/or image transmission log pointer identifier 350 ingredient bin of data link caster dart castings; whereas is depicted rhombic plane data, information, character, numeric, audio, voice, sound, video, post, copy, graphic, design, figure, object, picture and/or image . transmission recovery pointer identifier 351 element bin of data link caster dart castings. Whereas, within FIG. 6 is depicted an exploded flow chart comprising aforementioned UCMOST™ real-time processing and/or reprocessing of data and/or information microprocessor transmission interfacing with a real-time UCMOST™ treasuring information system hermetically isomorphic assize caustic transmuting identic syntactic transnational and/or translunar rubric universal spatiotemporal heliocentrically oscillating pragmatic sanction data link caster pelleting dart encasing composing distincitvely inseperable housing within pointer indentifier element 352 UCMOST™ CPU; whereas, thereof is ascertained preoccupying visualized prepossession of the richly dynamic, seamlessly functional, cohesively integrated and heliocentrical unifying aforementioned UCMOST™ real-time processing and/or reprocessing of data and/or information microprocessor transmission interfacing which is comprehensively suitable, generally pertinent and broadly useful to every and all transactional exchange embroidering aforementioned input plug data link caster dart castings evincing: high-quality accounting; high-quality reconciling; high-quality reporting; high-quality communicating; high-quality transporting; high-quality energizing; high-quality fueling; high-quality broadcasting; high-quality treasuring; high-quality distributing; high-quality financing; whereas, a novel and unobvious standalone symbolizing unified machine language real-time microprocessor formalizing data and/or information transmission concretizing real-time output plug data link caster dart castings facilitating every and all, without limitation, aforementioned UCMOST™ real-time processing and/or reprocessing of data and/or information microprocessor transmission interfacing within a standalone treasuring information system selected from the group consisting of propagating all conceptual aids hereto proclaiming and promulgating traversal of real-time transmission conduits selected from the heretofore traditional and/or hereto advanced level groups consisting of communications; wherefrom is depicted within FIG. 6 a multitude of standalone naturally rich, never faulting and never failing streamlined engineering utility and embroidered architectural design comprising element, component, constituent, factor and ingredient boosting whereas plugging ionic catalytic hermetic caustic casings entailing, encompassing, comprising, involving, impacting and effecting all prefabricated preparation and/or spontaneously baeysian randomizing occurrences, happenings, happenstances and/or transpirings; whereof, harnessing and leveraging a uniquely novel and unobvious composition evincing microelectronic AND/OR closed-circuitry hermetic soundproof housing and fireclay sealed wall casting fireball impervious engine carriage propagating, proclaiming and promulgating syntactic didactic transfiguration synthesis transnational identic transmuting atmospheric and/or translunar rubric pragmatic sanction; hermetically independent, holistically interoperable, heliocentrical object interlocking and inifinitely unified catholicon real-time microprocessor computer plug-compatible panacean caustic caster casing pod keyhole combinational object software code block; wherefrom, UCMOST™ real-time treasuring information system. Whereas, within FIG. 6 is depicted all of the richly dynamic, comprehensively fused, heliocentrical unifying and cohesively integrated aforementioned PUBLIC FINANCIALS™ real-time microprocessor transmission interfacing among the elements, components, constituents, factors and ingredients therein originating systematically prefix contracted and/or spontaneously prefix randomized data link caster casings from preformatted and/or preselected automatically accessible ledger balance account housing engine carriage comprising aforementioned UCMOST™ real-time treasuring information system; whereas, is depicted orthorhombic plane automatizing real-time treasuring system data and/or information input receiver pointer indentifier 353 element bin comprising holistic heliocentrically legal patent disclosure transfinite heremetic keyway combinational object software code lock up data link caster pelleting dart castings ledger account balances, whereof composing aforementioned UCMOST™ real-time processing and/or reprocessing of data and/or information microprocessor transmission interfacing herein below involving, housing and/or comprising data link caster pelleting dart casings of the following; whereas, is depicted orthorhombic plane automatizing real-time data and/or information treasuring order metric conversion station pointer identifier 354 component shelf of data link caster dart castings; whereas, is depicted helix whirling bay container automatizing data and/or information treasuring kick out/undo pointer identifier 355 constituent folder of data link caster dart castings; whereas, is depicted helix whirling bay container real-time data and/or information treasuring automatizing input spooling mechanism pointer identifier 356 factor reel of data link caster dart castings; whereas, is depicted orthorhombic plane automatizing data and/or information treasuring high-quality review station pointer identifier 357 ingredient shelf of data link caster dart castings; whereas, is depicted orthorhombic plane automatizing data and/or information treasuring system control station pointer identifier 358 element shelf of data link caster dart castings; whereas, is depicted orthorhombic plane real-time spatiotemporal data and/or information treasuring meter pointer identifier 359 component shelf of data link caster dart castings; whereas, is depicted orthorhombic plane real-time data and/or information treasuring custom control station pointer identifier 360 constituent shelf of data link caster dart castings; whereas, is depicted helix whirling bay container automatizing real-time data and/or information treasuring correction log pointer identifier 361 factor bin of data link caster dart castings; whereas, is depicted orthorhombic plane real-time automatizing data and/or information treasuring open-order match book pointer identifier 362 ingredient bin of data link caster dart castings; whereas, is depicted helix whirling bay container real-time open-order data and/or information treasuring file storage piont identifier 363 element pan of data link caster dart castings; whereas, is depicted helix whirling bay container real-time open-order data and/or information treasuring history file storage pointer identifier 364 component pan of data link caster dart castings; whereas, is depicted helix whirling bay container real-time open-order data and/or information treasuring statistics storage pointer identifier 365 constituent pan of data link caster dart castings; whereas, is depicted orthorhombic plane real-time open-order data and/or information treasuring transmission output pointer identifier 366 factor bin of data link caster dart castings; whereas, is depicted helix whirling bay container real-time open-order data and/or information treasuring transmission file storage pointer identifier 367 ingredient pan of data link caster dart castings; whereas, is depicted helix whirling bay container real-time open-order data transmission history file storage pointer identifier 368 element pan of data link caster dart castings; whereas, is depicted helix bay open-order information transmission storage pointer identifier 369 component pan of data link caster dart castings; whereas, is depicted helix bay data, information, character, numeric, audio, voice, sound, video, post, copy, graphic, design, figure, object, picture and/or image transmission log pointer identifier 370 constituent pan of data link caster dart castings; whereas, is depicted orthorhombic plane data, information, character, numeric, audio, voice, sound, video, post, copy, graphic, design, figure, object, picture and/or image transmission recovery pointer identifier 371 factor bin of data link caster dart castings; whereas, is depicted orthorhombic plane real-time validating data and/or information reporting station pointer identifier 372 ingredient shelf of data link caster dart castings; whereas, is depicted helix whirling bay container real-time validating data and/or information treasuring file storage pointer identifier 373 element pan of data link caster dart castings; whereas, is depicted helix whirling bay container real-time validating data and/or information treasuring history file storage pointer identifier 374 component pan of data link caster dart castings; whereas, is depicted helix whirling bay container real-time validating data and/or information treasuring statistics storage pointer identifier 375 constituent pan of data link caster dart castings; whereas, is depicted helix whirling bay container real-time data and/or information treasuring system matching station pointer identifier 376 factor bin of data link caster dart castings; whereas, is depicted helix whirling bay container real-time data and/or information treasuring system clearing station pointer identifier 377 ingredient bin of data link caster dart castings; whereas, is helix bay container real-time data and/or information treasuring system executing station pointer identifier 378 element bin of data link caster dart castings; whereas, is helix bay container real-time data and/or information treasuring system settling station pointer identifier 379 component bin of data link caster dart castings; whereas, is depicted helix whirling bay container real-time data and/or information treasuring system exchanging station pointer identifier 380 consituent bin of data link caster dart castings; whereas, is depicted helix whirling bay data and/or information container real-time accounting, communicating, transporting, reporting, energizing, fueling, treasuring, broadcasting, distributing and financing digital i.d. database pointer identifier 381 factor pan of data link caster dart castings; whereas, is depicted helix whirling bay container real-time data and/or information transnational and united states federal, state and local tax liability account ledger pointer identifier 382 element pan of data link caster dart castings; whereas, is depicted helix whirling bay container real-time data and/or information transnational and united states federal, state and local tax liability codification pointer identifier 383 component pan of data link caster dart castings; whereas, is depicted helix whirling bay container real-time data and/or information originating member ledger account payable data file ledger pointer identifier 384 constituent pan of data link caster dart castings; whereas, is depicted helix whirling bay container real-time data and/or information targeting member ledger account receivable data file ledger pointer identifier 385 factor pan of data link caster dart castings; whereas, is depicted helix whirling bay container real-time data and/or information united states ledger entity, encrypting internalized routing number and title ledger pointer identifier 386 ingredient pan of data link caster dart castings; whereas, is depicted helix whirling bay container real-time transnational ledger entity, encrypting internalized routing number and title ledger pointer identifier 387 element pan of data link caster dart castings; whereas, is depicted helix whirling bay container real-time data and/or information originating member ledger account payable data file ledger point ledger 388 component pan of data link caster dart castings; whereas, is depicted helix whirling bay container real-time data and/or information targeting member ledger account receivable data file ledger pointer identifier 389 constituent pan of data link caster dart castings; whereas, is depicted helix whirling bay container real-time data and/or information targeting member ledger account receivable data file ledger pointer identifier 390 factor pan of data link caster dart castings; whereas, is depicted helix whirling bay container real-time data and/or information originating member ledger account payable data file ledger pointer identifier 391 ingredient pan of data link caster dart castings; whereas, is depicted helix whirling bay container real-time data and/or information targeting member ledger account, routing number and title ledger pointer identifier 392 element pan of data link caster dart castings; whereas, is depicted helix whirling bay container real-time data and/or information originating member ledger account, routing number and title ledger pointer identifier 393 component pan of data link caster dart castings; whereas, is depicted orthorhombic plane real-time validating data and/or information treasuring transmission output pointer identifier 394 constituent bin of data link caster dart castings; whereas, is depicted helix whirling bay container real-time validating data treasuring tranmission file storage pointer identifier 395 factor bin of data link caster dart castings; whereas, is depicted helix whirling bay container real-time validating information treasuring transmission history file storage pointer identifier 396 ingredient bin of data link caster dart castings; whereas, is depicted helix whirling bay container treasuring data, information, character, numeric, audio, voice, sound, video, post, copy, graphic, design, figure, object, picture and/or image transmission storage pointer identifier 397 element bin of data link caster dart castings; whereas, is depicted helix whirling bay container data, information, character, numeric, audio, voice, sound, video, post, copy, graphic, design, figure, object, picture and/or image transmission log pointer identifier 398 component bin of data link caster dart castings; whereas, is depicted orthorhombic plane data, information, character, numeric, audio, voice, sound, video, post, copy, graphic, design, figure, object, picture and/or image transmission recovery pointer identifier 399 constituent bin of data link caster dart castings. Whereas, within FIG. 7 is depicted an exploded flow chart comprising aforementioned UCMOST™ real-time processing and/or reprocessing of data and/or information microprocessor transmission interfacing with a real-time UCMOST™ distributing information system hermetically isomorphic assize caustic transmuting identic syntactic transnational and/or translunar rubric universal spatiotemporal heliocentrically oscillating pragmatic sanction data link caster pelleting dart encasing composing distincitvely inseperable housing within pointer indentifier element 352 UCMOST™ CPU; whereas, thereof is ascertained preoccupying visualized prepossession of the richly dynamic, seamlessly functional, cohesively integrated and heliocentrical unifying aforementioned UCMOST™ real-time processing and/or reprocessing of data and/or information microprocessor transmission interfacing which is comprehensively suitable, generally pertinent and broadly useful to every and all transactional exchange embroidering aforementioned input plug data link caster dart castings evincing: high-quality accounting; high-quality reconciling; high-quality reporting; high-quality communicating; high-quality transporting; high-quality energizing; high-quality fueling; high-quality broadcasting; high-quality treasuring; high-quality distributing; high-quality financing; whereas, a novel and unobvious standalone symbolizing unified machine language real-time microprocessor formalizing data and/or information transmission concretizing real-time output plug data link caster dart castings facilitating every and all, without limitation, aforementioned UCMOST™ real-time processing and/or reprocessing of data and/or information microprocessor transmission interfacing within a standalone distributing information system selected from the group consisting of propagating all conceptual aids hereto proclaiming and promulgating traversal of real-time transmission conduits selected from the heretofore traditional and/or hereto advanced level groups consisting of communications; wherefrom is depicted within FIG. 7 a multitude of standalone naturally rich, never faulting and never failing streamlined engineering utility and embroidered architectural design comprising element, component, constituent, factor and ingredient boosting whereas plugging ionic catalytic hermetic caustic casings entailing, encompassing, comprising, involving, impacting and effecting all prefabricated preparation and/or spontaneously baeysian randomizing occurrences, happenings, happenstances and/or transpirings; whereof, harnessing and leveraging a uniquely novel and unobvious composition evincing microelectronic AND/OR closed-circuitry hermetic soundproof housing and fireclay sealed wall casting fireball impervious engine carriage propagating, proclaiming and promulgating syntactic didactic transfiguration synthesis transnational identic transmuting atmospheric and/or translunar rubric pragmatic sanction; hermetically independent, holistically interoperable, heliocentrical object interlocking and inifinitely unified catholicon real-time microprocessor computer plug-compatible panacean caustic caster casing pod keyhole combinational object software code block; wherefrom, UCMOST™ real-time distributing information system. Whereas, within FIG. 7 is depicted all of the richly dynamic, comprehensively fused, heliocentrical unifying and cohesively integrated aforementioned PUBLIC FINANCIALS™ real-time microprocessor transmission interfacing among the elements, components, constituents, factors and ingredients therein originating systematically prefix contracted and/or spontaneously prefix randomized data link caster casings from preformatted and/or preselected automatically accessible ledger balance account housing engine carriage comprising aforementioned UCMOST™ real-time distributing information system; whereas, is depicted orthorhombic plane automatizing real-time distributing system data and/or information input receiver pointer indentifier 400 element bin comprising holistic heliocentrically legal patent disclosure transfinite heremetic keyway combinational object software code lock up data link caster pelleting dart castings ledger account balances, whereof composing aforementioned UCMOST™ real-time processing and/or reprocessing of data and/or information microprocessor transmission interfacing herein below involving, housing and/or comprising data link caster pelleting dart casings of the following; whereas, is depicted orthorhombic plane automatizing real-time data and/or information distributing order metric conversion station pointer identifier 401 component shelf of data link caster dart castings; whereas, is depicted helix bay container automatizing data and/or information distributing kick out and/or undo pointer identifier 402 constituent folder of data link caster dart castings; whereas, is depicted helix bay container real-time data and/or information distributing automatizing input spooling mechanism pointer identifier 403 factor reel of data link caster dart castings; whereas, is depicted orthorhombic plane automatizing data and/or information distributing high-quality review station pointer identifier 404 ingredient shelf of data link caster dart castings; whereas, is depicted orthorhombic plane automatizing data and/or information distributing system control station pointer identifier 405 element shelf of data link caster dart castings; whereas, is depicted rhombic plane real-time spatiotemporal data and/or information distributing tracking meter station pointer identifier 406 component shelf of data link caster dart castings; whereas, is depicted orthorhombic plane real-time data and/or information spatiotemporal distributing tracking meter station pointer identifier 407 constituent shelf of data link caster dart castings; whereas, is depicted helix whirling bay container automatizing real-time data and/or information distributing correction log pointer identifier 408 factor bin of data link caster dart castings; whereas, is depicted orthorhombic plane real-time automatizing data and/or information distributing open-order match book pointer identifier 409 ingredient bin of data link caster dart castings; whereas, is depicted helix whirling bay container real-time open-order data and/or information distributing file storage pointer identifier 410 element pan of data link caster dart castings; whereas, is depicted helix whirling bay container real-time open-order data and/or information distributing history file storage pointer identifier 411 component pan of data link caster dart castings; whereas, is depicted helix whirling bay container real-time open-order data and/or information distributing statistics storage pointer identifier 412 constituent pan of data link caster dart castings; whereas, is depicted orthorhombic plane real-time open-order data and/or information distributing transmission output pointer identifier 413 factor bin of data link caster dart castings; whereas, is depicted helix whirling bay container real-time open-order data distributing transmission file storage pointer identifier 414 ingredient pan of data link caster dart castings; whereas, is depicted helix whirling bay container of real-time open-order information distributing transmission history file storage pointer identifier 415 element pan of data link caster dart castings; whereas, is depicted helix whirling bay container open-order data, information, character, numeric, audio, voice, sound, video, post, copy, graphic, design, figure, object, picture and/or image transmission storage pointer identifier 416 component pan of data link caster dart castings; whereas, is depicted helix whirling bay container data, information, character, numeric, audio, voice, sound, video, post, copy, graphic, design, figure, object, picture and/or image transmission log pointer identifier 417 constituent pan of data link caster dart castings; whereas, is depicted orthorhombic plane data, information, character, numeric, audio, voice, sound, video, post, copy, graphic, design, figure, object, picture and/or image transmission recovery pointer identifier 418 factor bin of data link caster dart castings; whereas, is depicted orthorhombic plane real-time validating data and/or information distributing station pointer identifier 419 ingredient shelf of data link caster dart castings; whereas, is depicted helix whirling bay container real-time validating data and/or information distributing file storage pointer identifier 420 element pan of data link caster dart castings; whereas, is depicted helix whirling bay container real-time validating data and/or information distributing history file storage pointer identifier 421 component pan of data link caster dart castings; whereas, is depicted helix whirling bay container real-time validating data and/or information distributing statistics storage pointer identifier 422 constituent pan of data link caster dart castings; whereas, is depicted helix whirling bay container real-time data and/or information distributing system matching station pointer identifier 423 factor bin of data link caster dart castings; whereas, is depicted helix whirling bay container real-time data and/or information distributing system clearing station pointer identifier 424 ingredient bin of data link caster dart castings; whereas, is depicted helix whirling bay container real-time data and/or information distributing system executing station pointer identifier 425 element bin of data link caster dart castings; whereas, is depicted helix whirling bay container real-time data and/or information distributing system settling station pointer identifier 426 component bin of data link caster dart castings; whereas, is depicted helix whirling bay container real-time data and/or information distributing system exchanging station pointer identifier 427 constituent bin of data link caster dart castings; whereas, is depicted helix whirling bay container treasuring, portfolio value(s), distributing limits, activities and integrated encrypting real-time iris scan visual, fingerprint and biotelemetry digital identified verification pointer identifier 428 factor pan of data link caster dart castings; whereas, is depicted helix whirling bay wealth access treasuring docs., trustee terms, provisions, portfolio restrictions and integrated encrypting real-time iris scan visual, finger and biotelemetry digital identified verification pointer identifier 429 ingredient pan of data link caster dart castings; whereas, is depicted helix whirling bay container risk management: home, rental, glider, caster, auto, flood, wind, storm, boiler, machinery, property, casualty, kidnapping, snatching, marine cargo and special lines pointer identifier 430 element pan of data link caster dart castings; whereas, is depicted helix whirling bay container risk management: life, major medical, ancillary medical, vision, disability, accidential death and dismemberment, director and officer, professional liability, worker compensation pointer identifier 431 container pan of data link caster dart castings; whereas, is depicted helix whirling bay container registered distributing and/or treasuring organizational financing instrument ensign flag identification pointer identifier 432 constituent pan of data link caster dart castings; whereas, is depicted helix whirling bay container new issue and secondary issue distributing and/or treasuring public financing offering instrument ensign flag identification pointer identifier 433 factor pan of data link caster dart castings; whereas, is depicted helix whirling bay container registered derivative american and/or european option contract distributing and/or treasuring public financing offering instrument ensign flag identification pointer identifier 434 element pan of data link caster dart castings; whereas, is depicted helix whirling bay container registered derivative forward, future, synthetic, warrant, swap, distributing, treasuring and financing offering instrument ensign flag identification pointer identifier 435 component pan of data link caster dart castings; whereas, is depicted helix whirling bay container equity, treasure, options, funds, trusts, 501(c)(3), 401(k), IRA, pensions, outstanding obligations, leasing obligations, tax liability encrypting real-time iris scan visual, finger and biotelemetry digital identified verification pointer identifier 436 constituent pan of data link caster dart castings; wherefrom, is depicted helix whirling bay container registered equity, treasure, derivative, index, real-estate trusts, unit trusts, closed funds, open finds, speciality finds instrument ensign flag identification pointer identifier 437 factor pan of data link caster dart castings; whereas, is depicted helix whirling bay container registered treasuring, commodities, treasuring covertibles, precious metals instrument ensign flag identification pointer identifier 438 ingredient pan of data link caster dart castings; whereas, is depicted helix whirling bay container registered treasure ledger account, trust account, 401(k), options, holding segment, new issue, secondary issue instrument ensign flag identification pointer identifier 439 element pan of data link caster dart castings; whereas, is depicted orthorhombic plane real-time validating data and/or information distributing transmission output pointer identifier 440 component bin of data link caster dart castings; whereas, is depicted helix whirling bay container real-time validating data distributing transmission file storage pointer identifier 441 constituent pan of data link caster dart castings; whereas, is depicted helix whirling bay container real-time validating information distributing transmission history file storage pointer identifier 442 factor pan of data link caster dart castings; whereas, is depicted helix whirling bay container real-time validating data, information, character, numeric, audio, voice, sound, video, post, copy, graphic, design, figure, object, picture and/or image transmission storage pointer identifier 443 ingredient pan of data link caster dart castings; whereas, is depicted helix bay real-time data, information, character, numeric, audio, voice, sound, video, post, copy, graphic, design, figure, object, picture and/or image transmission log pointer identifier 444 element pan of data link caster dart castings; whereas, is depicted rhombic plane data, information, character, numeric, audio, voice, sound, video, post, copy, graphic, design, figure, object, picture and/or image transmission recovery pointer identifier 445 component bin of data link caster dart castings. Whereas, within FIG. 8 is depicted an exploded flow chart comprising aforementioned UCMOST™ real-time processing and/or reprocessing of data and/or information microprocessor transmission interfacing with a real-time UCMOST™ financing information system hermetically isomorphic assize caustic transmuting identic syntactic transnational and/or translunar rubric universal spatiotemporal heliocentrically oscillating pragmatic sanction data link caster pelleting dart encasing composing distincitvely inseperable housing within pointer indentifier element 352 UCMOST™ CPU; whereas, thereof is ascertained preoccupying visualized prepossession of the richly dynamic, seamlessly functional, cohesively integrated and heliocentrical unifying aforementioned UCMOST™ real-time processing and/or reprocessing of data and/or information microprocessor transmission interfacing which is comprehensively suitable, generally pertinent and broadly useful to every and all transactional exchange embroidering aforementioned input plug data link caster dart castings evincing: high-quality accounting; high-quality reconciling; high-quality reporting; high-quality communicating; high-quality transporting; high-quality energizing; high-quality fueling; high-quality broadcasting; high-quality treasuring; high-quality distributing; high-quality financing; whereas, a novel and unobvious standalone symbolizing unified machine language real-time microprocessor formalizing data and/or information transmission concretizing real-time output plug data link caster dart castings facilitating every and all, without limitation, aforementioned UCMOST™ real-time processing and/or reprocessing of data and/or information microprocessor transmission interfacing within a standalone financing information system selected from the group consisting of propagating all conceptual aids hereto proclaiming and promulgating traversal of real-time transmission conduits selected from the heretofore traditional and/or hereto advanced level groups consisting of communications; wherefrom is depicted within FIG. 8 a multitude of standalone naturally rich, never faulting and never failing streamlined engineering utility and embroidered architectural design comprising element, component, constituent, factor and ingredient boosting whereas plugging ionic catalytic hermetic caustic casings entailing, encompassing, comprising, involving, impacting and effecting all prefabricated preparation and/or spontaneously baeysian randomizing occurrences, happenings, happenstances and/or transpirings; whereof, harnessing and leveraging a uniquely novel and unobvious composition evincing microelectronic AND/OR closed-circuitry hermetic soundproof housing and fireclay sealed wall casting fireball impervious engine carriage propagating, proclaiming and promulgating syntactic didactic transfiguration synthesis transnational identic transmuting atmospheric and/or translunar rubric pragmatic sanction; hermetically independent, holistically interoperable, heliocentrical object interlocking and inifinitely unified catholicon real-time microprocessor computer plug-compatible panacean caustic caster casing pod keyhole combinational object software code block; wherefrom, UCMOST™ real-time financing information system. Whereas, within FIG. 8 is depicted all of the richly dynamic, comprehensively fused, heliocentrical unifying and cohesively integrated aforementioned PUBLIC FINANCIALS™ real-time microprocessor transmission interfacing among the elements, components, constituents, factors and ingredients therein originating systematically prefix contracted and/or spontaneously prefix randomized data link caster casings from preformatted and/or preselected automatically accessible ledger balance account housing engine carriage comprising aforementioned UCMOST™ real-time financing information system; whereas, is depicted orthorhombic plane automatizing real-time financing system data and/or information input receiver pointer indentifier 446 element bin comprising holistic heliocentrically legal patent disclosure transfinite heremetic keyway combinational object software code lock up data link caster pelleting dart castings ledger account balances, whereof composing aforementioned UCMOST™ real-time processing and/or reprocessing of data and/or information microprocessor transmission interfacing herein below involving, housing and/or comprising data link caster pelleting dart casings of the following; whereas, is depicted orthorhombic plane automatizing real-time data and/or information financing order metric conversion station pointer identifier 447 component bin of data link caster dart castings; whereas, is depicted helix whirling bay container automatizing data and/or information financing kick out/undo folder pointer identifier 448 constituent bin of data link caster dart castings; whereas, is depicted helix whirling bay container real-time data and/or information financing automatizing input spooling mechanism pointer identifier 449 factor reel of data link caster dart castings; whereas, is depicted orthorhombic plane automatizing real-time data and/or information financing high-quality review station pointer identifier 450 ingredient shelf of data link caster dart castings; whereas, is depicted orthorhombic plane automatizing real-time data and/or information financing system control station pointer identifier 451 element shelf of data link caster dart castings; whereas, is depicted orthorhombic plane real-time data and/or information spatiotemporal financing tracking meter station pointer identifier 452 component shelf of data link caster dart castings; whereas, is depicted orthorhombic plane real-time data and/or information financing custom control station pointer identifier 453 constituent shelf of data link caster dart castings; whereas, is depicted helix whirling bay container automatizing real-time data and/or information financing correction log pointer identifier 454 factor bin of data link caster dart castings; whereas, is depicted orthorhombic plane open-order automatizing real-time data and/or information financing match book pointer identifier 455 ingredient bin of data link caster dart castings; whereas, is depicted helix whirling bay container open-order real-time data and/or information financing file storage pointer identifier 456 element pan of data link caster dart castings; whereas, is depicted helix whirling bay container open-order real-time data and/or information financing history file storage pointer identifier 457 component pan of data link caster dart castings; whereas, is depicted helix whirling bay container open-order real-time data and/or information financing statistics storage pointer identifier 458 constitutent pan of data link caster dart castings; whereas, is depicted orthorhombic plane open-order real-time data and/or information financing transmission output pointer identifier 459 factor bin of data link caster dart castings; whereas, is depicted helix whilring bay container open-order real-time data financing transmission file storage pointer identifier 460 ingredient pan of data link caster dart castings; whereas, is depicted helix whirling bay container open-order real-time information transmission history file storage pointer identifier 461 element pan of data link caster dart castings; whereas, is depicted helix whirling bay container data, information, character, numeric, audio, voice, sound, video, post, copy, graphic, design, figure, object, picture and/or image transmission storage pointer identifier 462 component pan of data link caster dart castings; whereas, is depicted helix whirling bay container data, information, character, numeric, audio, voice, sound, video, post, copy, graphic, design, figure, object, picture and/or image transmission log pointer identifier 463 constituent pan of data link caster dart castings; whereas, is depicted orthorhombic plane data, information, character, numeric, audio, voice, sound, video, post, copy, graphic, design, figure, object, picture and/or image trasmit recovery pointer identifier 464 factor bin of data link caster dart castings; whereas, is depicted orthorhombic plane spatiotemporal real-time data and/or information tier-1 heliocentrical treasuring pointer identifier 465 ingredient bin of data link caster dart castings; whereas, is depicted orthorhombic plane spatiotemporal real-time data and/or information tier-2 transnational and/or national treasuring pointer identifier 466 element bin of data link caster dart castings; whereas, is depicted orthorhombic plane spatiotemporal real-time data and/or information tier-3 state and local treasuring pointer identifer 467 component bin of data link caster dart castings; whereas, is depicted orthorhombic plane automatizing real-time data and/or information financing validation station pointer identifier 468 factor shelf of data link caster dart castings; whereas, is depicted helix whirling bay container real-time validating data and/or information financing file storage pointer identifier 469 ingredient pan data link caster dart castings; whereas, is depicted helix whirling bay container real-time validating data and/or information financing history file storage pointer identifier 470 element pan data link caster dart castings; whereas, is depicted helix whirling bay container real-time validating data and/or information financing statistics storage pointer identifier 471 component pan of data link caster dart castings; whereas, is depicted orthorhombic plane real-time validating data and/or information financing transmission output pointer identifier 472 constituent pan of data link caster dart castings; whereas, is depicted helix whirling bay container real-time validating data financing transmission file storage pointer identifier 473 factor pan of data link caster dart castings; whereas, is depicted helix whirling bay container real-time validating information financing transmission history file storage pointer identifier 474 ingredient pan of data link caster dart castings; whereas, is depicted helix whirling bay container data, information, character, numeric, audio, voice, sound, video, post, copy, graphic, design, figure, object, picture and/or image transmission storage pointer identifier 475 element pan of data link caster dart castings; whereas, is depicted helix whirling bay container data, information, character, numeric, audio, voice, sound, video, post, copy, graphic, design, figure, object, picture and/or image transmission log pointer identifier 476 component pan of data link caster dart castings; whereas, is depicted orthorhombic plane data, information, character, numeric, audio, voice, sound, video, post, copy, graphic, design, figure, object, picture and/or image trasmitting recovery pointer identifier 477 constituent bin of data link caster dart castings.

### OPERATION OF INVENTION

Whereas, aforementioned UCMOST™ real-time processing and/or reprocessing comprises a complete real-time microprocessor logic instructing sub-loculated originating real-time software generator AND-OR closed-circuitry microprocessor operating system computing code block concretizing rubric identic pragmatic sanction automatizing holistically steady state synchronized ubiquitous continuum universal executive microprogrammable systematized codification microprocessor machine language logic operator instruction of one-time programmable read-only memory (PROM) evincing a multiport revolving chambered homing binary hunting metallic track encasing hermetic data link caster dart castings constrained utility engineering block protective contactor composite soundproof housing and fireclay sealed wall casting fireball impervious carriage data link caster dart castings accumulator hardcore controlling central processing unit (CPU) originating onto every and all, without limitation, microprocessor semi-conducting chips comprehensively suitable, generally pertinent and broadly useful to every and all aforementioned efficient UNIVERSAL CAPITAL MARKET™ conceptual aids propagating across-the-board traversal of every and all, without limitation, integrated aforementioned efficient UNIVERSAL CAPITAL MARKET™ communications; whereas, wherefrom all of which clearly, undeniably, logically, scientifically and intuitively entail, encompass, comprise, involve, impact and effect every and all high-quality: real-time accounting; real-time communicating; real-time transporting; real-time energizing; real-time reconciling; real-time broadcasting; real-time fueling; real-time reporting; real-time treasuring; real-time distributing; real-time financing; wherefrom, furthermore evincing every and all of the following heliocentrically internalizing and holistically centralizing UCMOST™ accumulator unicore controlling central processing unit (CPU) whose universal dominion domain harnesses and leverages every and all software articles, software programs, software and/or hardware peripherals and/or software and/or hardware components; whereas, thereto incorporating all logic operator instructional methods, capacities, processes and combinations via the hereinabove and hereinbelow aforementioned melioristic logical positivism machine language. Whereas, aforementioned UCMOST™ real-time processing is completely and entirely comprehensively suitable, generally pertinent and broadly useful to all of the following characteristics: mental, audio, visual, taste, touch and smell oriented apprehending and cognizably appearing, recognizing, identifying, acknowledging, associating, filtering, sorting, organizing, conceptualizing, understanding and comprehending every and all, without limitation, representational abstract conceptual aids entailing, encompassing, comprising, involving, impacting and effecting, without limitation, all of the following: retrieving; converting; formatting; processing; storing; gathering; compiling; tabulating; casting; calculating; preparing; editing; tracing; verifying; submitting; confirming; validating; booking; classifying; categorizing; adjusting; altering; revising; changing; billing; collecting; producing; composing; conducting; proofing; filtering; pressing; publishing; cataloging; indexing; scripting; locating; shooting; running; releasing; posting; compressing; presenting; releasing; playing; displaying; projecting; broadcasting; syndicating; whereas, moreover aforementioned UCMOST™ real-time reprocessing is comprehensively suitable, generally pertinent and broadly useful to every and all of the following: mental, audio, visual, taste, touch and smell oriented apprehending and cognizably appearing, recognizing, identifying, acknowledging, associating, filtering, sorting, organizing, conceptualizing, understanding and comprehending every and all, without limitation, representational abstract conceptual aids entailing, encompassing, comprising, involving, impacting and effecting, without limitation, all of the following: reretrieval; retransport; reconversion; reformatting; reprocessing; resaving; restoring; reidentifying; regathering; resorting; reorganizing; recompiling; retabulating; recasting; recalculating; repreparing; reediting; retracing; reverifying; resubmitting; reconfirming; revalidating; rebooking; reclassifying; recategorizing; readjusting; realtering; rerevising; rechanging; recharging; rebilling; recollecting; reproducing; recomposing; reconducting; reproofing; refiltering; repressing; republishing; recataloging; reindexing; rescripting; relocating; reshooting; rerunning; rereleasing; reposting; recompressing; representing; rereleasing; replaying; redisplaying; reprojecting; rebroadcasting; resyndicating within, throughout and transcending a single transnational econometric marketplace envirment all of which, without limitation, clearly, undeniably, logically, scientifically and intuitively entail, encompass, comprise, involve, impact and effect transactional economic resources, financial transactions, operational occurrences, recurring events, miscellaneous items, and cost or expense driven initiatives, schemes, ocurrences, happenings, interactions, processes, methods, practices, movements, proceedings, messaging, presentations, notifications, filings, submissions, records, activities, actions, events, endeavors, tasks and affairs via every and all concretizing articles, apparatuses, megastructures, peripherals, elements, components, constituents, factors, ingredients, occurences, happenings, happenstance and/or transpirings via the course of normal and/or atypical operational, administrative and/or management activities within, throughout and transcending a cosmos transnational econometric marketplace environment comprising every and all elementary and/or basic levels of subsistence and acess to wealth and/or prosperity inclusive of currency prevalence, accessibility to property and abundance of and/or to econometric physicalistic products, goods, services and/or supplies naturally requited by tens of hundreds of millions of individual members of the aforementioned UNIVERSAL POPULACE™. Whereas, within FIG. 1, is depicted an imploded view comprising UCMOST™ central microprocessor unit; wherefrom, propagating traversal of every and all traditonal mechanical friction and/or chemical reaction to fuel power and energy conduit electrical and/or battery generation inclusive of every and all advanced electronic locational systematizing geological and/or seismological processes concretizing innovative wheresoever transcendent EPROM, degauss and/or magnetostriction preemptively constrained ferromagnetic alloy, silicon, germanium, biodynamic and/or geomagnetic resonant soundproof and fireclay wall protective fireball impervious microcircuit epoxy casting insulated permeability of artificial semi-conducting microcircuit devices, articles, apparatuses, refractories and/or megastructures internalizing upright orthorhombic tentacular boundless steady state roving antennule transmuting metric conversional transistor transfusing receiver concretizing high-quality holistically steady state heliocentrically synchronizing ubiquitous hunting continuum parallel redundancy cosmos robotizing digitalized galactic transmitting receiver of spatiotemporal emitted broadcasting of real-time microprocessing traversing a single independent portal refractory evincing minutia partible iota beta particle trace element wave front continuous spectrum pulse signaling transmission conveying efficient energizing and fueling powered catalytic conduits via electrogasdynamics, electrogenesis, electrohydraulic, geomagnetic, gyromagnetic, geokinetic and/or thermodynamic setting transistorized rheostat regulated transfusing partible trace element staple actualizing atmospheric, lunar, translunar and/or intergalactic gyroscopic axisymmetrical stabilizing self-impetus housing protective carriage; whereas, hereinabove aformentioned enabling portable rove bearing and/or fixture directed rove bearing electronic interfacing between and among various protective levels of metallic track sealed encasings which incorporate multifaceted layers of interactions of UCMOST™ via real-time interactivity propagating traverse of various multifaceted and multidimensional sub-loculated elements, components, constituents, factors and/or ingredients all of which are by this reference and conceptualizing figurative drawing inclusive of, without limitation, the above and below specifications of my legal patent disclosure, evincing a complete consummate and constructive reduction to practice of a machine, process, capacity, methodology and combination via cohesively fusing via the following: concretizing; chambering; harnessing; soldifying; linking; providing; enjoining; chaining; empowering; facilitating; enabling; harnessing; leveraging; embroidering; actualizing; wherefrom, every and all, internalized and integral elements, components, constituents, factors and ingredients actualizing aforementioned UCMOST™ real-time processing and/or reprocessing which clearly, undeniably, logically, scientifically and intuitively entail, encompass, comprise, involve, impact and effect all internalizing distinctive sub-loculated: intergrating; interlacing; interleaving interchaining; interlocling; intertwining; intercombining; intercoupling; inteijoining; interlinking; interpaving; interlacing; intercoiling; interwhirling; intertwining; interfastening; wherefrom novel sub-loculation information systems concretizing aforementioned standalone UCMOST™ information technology. Whereas, UCMOST™ evinces a complete and consummate constructive reduction to practice of a controlling unified microprocessor computing operating system housing caster carriage propagating every and all real-time econometric transnational transactional initiatives, schemes, ocurrences, happenings, interactions, processes, methods, practices, movements, proceedings, messaging, presentations, notifications, filings, submissions, records, activities, actions, events, endeavors, tasks and affairs via all conveyance and/or all traverse evincing a novel, unobvious, unforseen, epoch, unprecedented, ease of use and simplied utlity engineering and aesthetic architectural design enbaling a uniquely innovative work of art. Whereas, within FIG. 1 is 101 a security closed-circuit hardcore UCMOST™ casting block which prevents all breach and entirely precludes reengineering of UCMOST™ inclusive of, without limitation, integral and interloculated applications software processing apostrophe interface station 102; wherefrom, 103 encasing combinatinal keyway pod station serves as orthorhombic front-end logical operator point-of-service interface with every and all, without limitation, of the above aforementioned innovatively conceived, methodological attributive and richly dynamic descriptive encased applications software processing data link caster darting program stations: 104; 105; 106; 107; 108; 109; 110; 111; 112; 113; 114; 115; 116; 117; 118; 119; 120; 121; 122; 123; 124; 125; 126; 127; 128; 129; 130; 131; 132; 133. Whereas, within FIG. 2 is depicted every and all UCMOST™ microprocessor logical operator instructions driven interactivity with sub-loculated information system occuring, happening and/or transpiring exclusively via multifaceted and multidimensional engineering hardcore software microcircuitry contactor protective orthorhombic plane UCMOST™ operating system encasing 134 block pod station. Whereas, 134 propagating directional electrical groove pulsatory signaling interfacing transmission line data link conveyance rythmically transporting all dart trace element pelleting from 135 UCMOST™ controlling central microprocessing unit to/from 352 UCMOST™ controlling central microprocessing unit; whereas, directional electrical groove intercoiling enabling real-time multidimensional 135 UCMOST™ parallel processing as a never faulting and never failing octagonal multitrack redudancy electrical contactor connecting multidimensional pulsatory signaling interfacing transmission line with loculated aforementioned 352 UCMOST™; whereas, evincing a multifaceted transcendental and multidimensional combinational rubricating identic pragmatic sanction of heliocentrical automatizing steady state holistically synchronized ubiquitous continuum universal executive microprogrammable systematic microprocessor machine language codification of logic operator instruction of one-time programmable read-only memory (PROM); whereas, actualizing multiport revolving chambered homing binary hunting octagonal pulsatory signaling transmission line metallic caster track iota beta trace element electrical circuitry; wherefrom, concretizing a uniquely designed and meticulously engineered epoch enabling utility engineering and architectural design technological bridge transmission microcircuit platform evincing every and all, without limitation, of the following high-quality: real-time accounting; real-time communicating; real-time transporting; real-time energizing; real-time reconciling; real-time broadcasting; real-time fueling; real-time reporting; real-time treasuring; real-time distributing; real-time financing. Whereas, within FIG. 3 is depicted the cohesively fused elements, components, constituents, factors and ingredients locuated within 135 UCMOST™ accounting information system; whereas, every and all data link caster dart pellet real-time operational system computing processing data flow originating with any and/or all orthorhombic planes automatizing real-time accounting system data and/or information input receiver pointer indentifiers: 136; 137; 138; 139; 140; whereas, evincing logical operator element bins enabling aforementioned 135 real-time microprocessing characteristic grouping attributes; whereas, 134 propagating directional electrical groove pulsatory signaling interfacing transmission line data link conveyance rythmically transporting all dart trace element pelleting to receiver 136; whereas, propagating directional electrical groove pulsatory signaling interfacing transmission line data link conveyance rythmically transporting all dart trace element pelleting to receiver 137; whereas, 137 propagating directional electrical groove pulsatory signaling interfacing transmission line data link conveyance rythmically transporting all dart trace element pelleting to receiver 138; whereas, 138 propagating directional electrical groove pulsatory signaling interfacing transmission line data link conveyance rythmically transporting all dart trace element pelleting to receiver 139; whereas, 139 propagating directional electrical groove pulsatory signaling interfacing transmission line data link conveyance rythmically transporting all dart trace element pelleting to receiver 140; whereas, 140 propagating directional electrical groove pulsatory signaling interfacing transmission line data link conveyance rythmically transporting all dart trace element pelleting whereby docking all dart pelleting at receiver 141; whereas, otherwise evincing logical operator element bins enabling aforementioned 135 real-time microprocessing characteristic grouping attributes; whereas, 134 propagating directional electrical groove pulsatory signaling interfacing transmission line data link conveyance rythmically transporting all dart trace element pelleting to receiver 137; whereas, 137 propagating directional electrical groove pulsatory signaling interfacing transmission line data link conveyance rythmically transporting all dart trace element pelleting to receiver 138; whereas, 138 propagating directional electrical groove pulsatory signaling interfacing transmission line data link conveyance rythmically transporting all dart trace element pelleting to receiver 139; whereas, 139 propagating directional electrical groove pulsatory signaling interfacing transmission line data link conveyance rythmically transporting all dart trace element pelleting to receiver 140; whereas, 140 propagating directional electrical groove pulsatory signaling interfacing transmission line data link conveyance rythmically transporting all dart trace element pelleting whereby docking all dart pelleting at receiver 141; whereas, moreover, additionally characteristically eliciting successive albeit shorter length traverse evincing logical operator element bins enabling aforementioned 135 real-time microprocessing characteristic grouping attributes; whereas, 134 propagating directional electrical groove pulsatory signaling interfacing transmission line data link conveyance rythmically transporting all dart trace element pelleting to receiver 138; whereas, 138 propagating directional electrical groove pulsatory signaling interfacing transmission line data link conveyance rythmically transporting all dart trace element pelleting to receiver 139; whereas, 139 propagating directional electrical groove pulsatory signaling interfacing transmission line data link conveyance rythmically transporting all dart trace element pelleting to receiver 140; whereas, 140 propagating directional electrical groove pulsatory signaling interfacing transmission line data link conveyance rythmically transporting all dart trace element pelleting whereby docking all dart pelleting at receiver 141; whereas, furthermore facilitating traverse evincing logical operator element bins enabling aforementioned 135 real-time microprocessing characteristic grouping attributes; whereas, 134 propagating directional electrical groove pulsatory signaling interfacing transmission line data link conveyance rythmically transporting all dart trace element pelleting to receiver 139; whereas, 139 propagating directional electrical groove pulsatory signaling interfacing transmission line data link conveyance rythmically transporting all dart trace element pelleting to receiver 140; whereas, 140 propagating directional electrical groove pulsatory signaling interfacing transmission line data link conveyance rythmically transporting all dart trace element pelleting whereby docking all dart pelleting at receiver 141; whereas, moreover, enabling traverse evincing logical operator element bins enabling aforementioned 135 real-time microprocessing characteristic grouping attributes; whereas, 134 propagating directional electrical groove pulsatory signaling interfacing transmission line data link conveyance rythmically transporting all dart trace element pelleting to receiver 140; whereas, 140 propagating directional electrical groove pulsatory signaling interfacing transmission line data link conveyance rythmically transporting all dart pellet trace whereby docking all dart pelleting at receiver 141; whereas, housing carriage consolidating input receiver 141 evincing aforementioned UCMOST™ real-time processing enabling efficient accumulator characteristically grouping, identifying, organizing and sorting methodology whereby evincing formatting of data caster dart pellet trace evincing logical operator propagating directional electrical groove pulsatory signaling interfacing transmission line data link conveyance rythmically transporting all dart trace element pelleting whereby docking all dart pelleting to 147; whereas, 147 propagating directional electrical groove pulsatory signaling interfacing transmission line data link conveyance rythmically transporting all dart trace element pelleting to 143; whereas, 147 propagating directional electrical groove pulsatory signaling interfacing transmission line data link conveyance rythmically transporting all dart trace element pelleting to/from 142; whereas, 147 propagating directional electrical groove pulsatory signaling interfacing transmission line data link conveyance rythmically transporting all dart trace element pelleting to/from 144; whereas, 147 propagating directional electrical groove pulsatory signaling interfacing transmission line data link conveyance rythmically transporting all dart trace element pelleting to/from 152; whereas, 147 enabling metric conversion formatting of preidentified, preorganized, presorted, preverified and prelabeled all dart trace element pelleting whereby propagating directional electrical groove pulsatory signaling interfacing transmission line data link conveyance rythmically transporting all dart trace element pelleting to 145; whereas, 145 enabling preformatted open-order match book making propagating directional electrical groove pulsatory signaling interfacing transmission line data link conveyance rythmically transporting all dart trace element pelleting to 151; whereas, 151 propagating directional electrical groove pulsatory signaling interfacing transmission line data link conveyance rythmically transporting all dart trace element pelleting to 157; whereas, 157 propagating directional electrical groove pulsatory signaling interfacing transmission line data link conveyance rythmically transporting all dart trace element pelleting to 159; whereas, 151 propagating directional electrical groove pulsatory signaling interfacing transmission line data link conveyance rythmically transporting all dart trace element pelleting to 158; whereas, 158 propagating directional electrical groove pulsatory signaling interfacing transmission line data link conveyance rythmically transporting all dart trace element pelleting to 159; whereas, 151 propagating directional electrical groove pulsatory signaling interfacing transmission line data link conveyance rythmically transporting all dart trace element pelleting to/from 161; whereas, 161 propagating directional electrical groove pulsatory signaling interfacing transmission line data link conveyance rythmically transporting all dart trace element pelleting to/from 162; whereas, 161 propagating directional electrical groove pulsatory signaling interfacing transmission line data link conveyance rythmically transporting all dart trace element pelleting to/from 163; wheras, 161 propagating directional electrical groove pulsatory signaling interfiacing transmission line data link conveyance rythmically transporting all dart trace element pelleting to/from 164; whereas, 151 propagating directional electrical groove pulsatory signaling interfacing transmission line data link conveyance rythmically transporting all dart trace element pelleting to/from 165; whereas, 165 propagating directional electrical groove pulsatory signaling interfacing transmission line data link conveyance rythmically transporting all dart trace element pelleting to/from 166; whereas, 165 propagating directional electrical groove pulsatory signaling interfacing transmission line data link conveyance rythmically transporting all dart trace element pelleting to/from 166; whereas, 165 propagating directional electrical groove pulsatory signaling interfacing transmission line data link conveyance rythmically transporting all dart trace element pelleting to/from 167; whereas, 165 propagating directional electrical groove pulsatory signaling interfacing transmission line data link conveyance rythmically transporting all dart trace element pelleting to/from 168; whereas, 151 propagating directional electrical groove pulsatory signaling interfacing transmission line data link conveyance rythmically transporting all dart trace element pelleting to/from 169; whereas, 169 propagating directional electrical groove pulsatory signaling interfacing transmission line data link conveyance rythmically transporting all dart trace element pelleting to/from 170; whereas, 169 propagating directional electrical groove pulsatory signaling interfacing transmission line data link conveyance rythmically transporting all dart trace element pelleting to/from 171; whereas, 169 propagating directional electrical groove pulsatory signaling interfacing transmission line data link conveyance rythmically transporting all dart trace element pelleting to 172; whereas, 151 propagating directional electrical groove pulsatory signaling interfacing transmission line data link conveyance rythmically transporting all dart trace element pelleting to/from 173; whereas, 173 propagating directional electrical groove pulsatory signaling interfacing transmission line data link conveyance rythmically transporting all dart trace element pelleting to/from 174; whereas, 173 propagating directional electrical groove pulsatory signaling interfacing transmission line data link conveyance rythmically transporting all dart trace element pelleting to/from 175; whereas, 173 propagating directional electrical groove pulsatory signaling interfacing transmission line data link conveyance rythmically transporting all dart trace element pelleting to/from 176; whereas, 151 propagating directional electrical groove pulsatory signaling interfacing transmission line data link conveyance rythmically transporting all dart trace element pelleting to/from 177; whereas, 177 propagating directional electrical groove pulsatory signaling interfacing transmission line data link conveyance rythmically transporting all dart trace element pelleting to/from 178; whereas, 177 propagating directional electrical groove pulsatory signaling interfacing transmission line data link conveyance rythmically transporting all dart trace element pelleting to/from 179; whereas, 177 propagating directional electrical groove pulsatory signaling interfacing transmission line data link conveyance rythmically transporting all dart trace element pelleting to/from 180; whereas, 151 propagating directional electrical groove pulsatory signaling interfacing transmission line data link conveyance rythmically transporting all dart trace element pelleting to/from 181; whereas, 181 propagating directional electrical groove pulsatory signaling interfacing transmission line data link conveyance rythmically transporting all dart trace element pelleting to/from 182; whereas, 181 propagating directional electrical groove pulsatory signaling interfacing transmission line data link conveyance rythmically transporting all dart trace element pelleting to/from 183; whereas, 181 propagating directional electrical groove pulsatory signaling interfacing transmission line data link conveyance rythmically transporting all dart trace element pelleting to/from 184; whereas, 151 propagating directional electrical groove pulsatory signaling interfacing transmission line data link conveyance rythmically transporting all dart trace element pelleting to master general ledger 148; whereas, 148 propagating directional electrical groove pulsatory signaling interfacing transmission line data link conveyance rythmically transporting all dart trace element pelleting to 153; whereas, 153 propagating directional electrical groove pulsatory signaling interfacing transmission line data link conveyance rythmically transporting all dart trace element pelleting to 155; whereas, 148 propagating directional electrical groove pulsatory signaling interfacing transmission line data link conveyance rythmically transporting all dart trace element pelleting to 154; whereas, 154 propagating directional electrical groove pulsatory signaling interfacing transmission line data link conveyance rythmically transporting all dart trace element pelleting to 155; whereas, 148 propagating directional electrical groove pulsatory signaling interfacing transmission line data link conveyance rythmically transporting all dart trace element pelleting to preformatted broadcasting output real-time transmission 185; whereas, 185 propagating directional electrical groove pulsatory signaling interfacing transmission line data link conveyance rythmically transporting all dart trace element pelleting to 134; whereas, 185 propagating directional electrical groove pulsatory signaling interfacing transmission line data link conveyance rythmically transporting all dart trace element pelleting to 186; whereas, 186 propagating directional electrical groove pulsatory signaling interfacing transmission line data link conveyance rythmically transporting all dart trace element pelleting to trace recovery preformatted broadcasting output real-time transmission 190; whereas, 185 propagating directional electrical groove pulsatory signaling interfacing transmission line data link conveyance rythmically transporting all dart trace element pelleting to 187; whereas, 187 propagating directional electrical groove pulsatory signaling interfacing transmission line data link conveyance rythmically transporting all dart trace element pelleting to 190; whereas, 185 propagating directional electrical groove pulsatory signaling interfacing transmission line data link conveyance rythmically transporting all dart trace element pelleting to 188; whereas, 188 propagating directional electrical groove pulsatory signaling interfacing transmission line data link conveyance rythmically transporting all dart trace element pelleting to 190; whereas, 185 propagating directional electrical groove pulsatory signaling interfacing transmission line data link conveyance rythmically transporting all dart trace element pelleting to 189; whereas, 189 propagating directional electrical groove pulsatory signaling interfacing transmission line data link conveyance rythmically transporting all dart trace element pelleting to 190; whereas, 190 propagating directional electrical groove pulsatory signaling interfacing transmission line data link conveyance rythmically transporting all dart trace element pelleting to 134. Whereas, within FIG. 4 is depicted the cohesively fused elements, components, constituents, factors and ingredients locuated within 135 UCMOST™ reconciling information system; whereas, 134 propagating directional electrical groove pulsatory signaling interfacing transmission line data link conveyance rythmically transporting all dart trace element pelleting data flow originating within orthorhombic plane automatizing real-time reconciling system data and/or information input receiver pointer indentifier 191; whereas, housing carriage consolidating input receiver 191 evincing aforementioned UCMOST™ real-time processing enabling efficient accumulator characteristically grouping, identifying, organizing and sorting methodology whereby evincing formatting of data caster dart pellet trace evincing logical operator propagating directional electrical groove pulsatory signaling interfacing transmission line data link conveyance rythmically transporting all dart trace element pelleting whereby docking all dart pelleting to 192; whereas, 192 propagating directional electrical groove pulsatory signaling interfacing transmission line data link conveyance rythmically transporting all dart trace element pelleting to 198; whereas, 192 propagating directional electrical groove pulsatory signaling interfacing transmission line data link conveyance rythmically transporting all dart trace element pelleting to/from 197; whereas, 192 propagating directional electrical groove pulsatory signaling interfacing transmission line data link conveyance rythmically transporting all dart trace element pelleting to open-order match book 196; whereas, 196 propagating directional electrical groove pulsatory signaling interfacing transmission line data link conveyance rythmically transporting all dart trace element pelleting to 207; whereas, 207 propagating directional electrical groove pulsatory signaling interfacing transmission line data link conveyance rythmically transporting all dart trace element pelleting to 209; whereas, 196 propagating directional electrical groove pulsatory signaling interfacing transmission line data link conveyance rythmically transporting all dart trace element pelleting to 208; whereas, 208 propagating directional electrical groove pulsatory signaling interfacing transmission line data link conveyance rythmically transporting all dart trace element pelleting to 209; whereas, 196 propagating directional electrical groove pulsatory signaling interfacing transmission line data link conveyance rythmically transporting all dart trace element pelleting to broadcasting open-order output real-time transmission 225; whereas, 225 propagating directional electrical groove pulsatory signaling interfacing transmission line data link conveyance rythmically transporting all dart trace element pelleting to 134; whereas, 225 propagating directional electrical groove pulsatory signaling interfacing transmission line data link conveyance rythmically transporting all dart trace element pelleting to 226; whereas, 226 propagating directional electrical groove pulsatory signaling interfacing transmission line data link conveyance rythmically transporting all dart trace element pelleting to trace recovery broadcasting open-order output real-time transmission 230; whereas, 225 propagating directional electrical groove pulsatory signaling interfacing transmission line data link conveyance rythmically transporting all dart trace element pelleting to 227; whereas, 227 propagating directional electrical groove pulsatory signaling interfacing transmission line data link conveyance rythmically transporting all dart trace element pelleting to 230; whereas, 225 propagating directional electrical groove pulsatory signaling interfacing transmission line data link conveyance rythmically transporting all dart trace element pelleting to 228; whereas 228 propagating directional electrical groove pulsatory signaling interfacing transmission line data link conveyance rythmically transporting all dart trace element pelleting to 230; whereas, 225 propagating directional electrical groove pulsatory signaling interfacing transmission line data link conveyance rythmically transporting all dart trace element pelleting to 229; whereas, 229 propagating directional electrical groove pulsatory signaling interfacing transmission line data link conveyance rythmically transporting all dart trace element pelleting to 230; whereas, 230 propagating directional electrical groove pulsatory signaling interfacing transmission line data link conveyance rythmically transporting all dart trace element pelleting to 134; whereas; 196 propagating directional electrical groove pulsatory signaling interfacing transmission line data link conveyance rythmically transporting all dart trace element pelleting to validation station 206; whereas, 206 propagating directional electrical groove pulsatory signaling interfacing transmission line data link conveyance rythmically transporting all dart trace element pelleting to/from 201; whereas, 201 propagating directional electrical groove pulsatory signaling interfacing transmission line data link conveyance rythmically transporting all dart trace element pelleting to/from 202; whereas, 206 propagating directional electrical groove pulsatory signaling interfacing transmission line data link conveyance rythmically transporting all dart trace element pelleting to/from 202; whereas, 202 propagating directional electrical groove pulsatory signaling interfacing transmission line data link conveyance rythmically transporting all dart trace element pelleting to/from 203; whereas, 206 propagating directional electrical groove pulsatory signaling interfacing transmission line data link conveyance rythmically transporting all dart trace element pelleting to/from 203; whereas, 203 propagating directional electrical groove pulsatory signaling interfacing transmission line data link conveyance rythmically transporting all dart trace element pelleting to/from 204; whereas, 206 propagating directional electrical groove pulsatory signaling interfacing transmission line data link conveyance rythmically transporting all dart trace element pelleting to/from 204; whereas, 204 propagating directional electrical groove pulsatory signaling interfacing transmission line data link conveyance rythmically transporting all dart trace element pelleting to/from 205; whereas, 206 propagating directional electrical groove pulsatory signaling interfacing transmission line data link conveyance rythmically transporting all dart trace element pelleting to/from 205; whereas, 206 propagating directional electrical groove pulsatory signaling interfacing transmission line data link conveyance rythmically transporting all dart trace element pelleting to/from 224; whereas, 206 propagating directional electrical groove pulsatory signaling interfacing transmission line data link conveyance rythmically transporting all dart trace element pelleting to/from 223; whereas, 206 propagating directional electrical groove pulsatory signaling interfacing transmission line data link conveyance rythmically transporting all dart trace element pelleting to/from 222; whereas, 206 propagating directional electrical groove pulsatory signaling interfacing transmission line data link conveyance rythmically transporting all dart trace element pelleting to/from 221; whereas, 206 propagating directional electrical groove pulsatory signaling interfacing transmission line data link conveyance rythmically transporting all dart trace element pelleting to/from 220; whereas, 206 propagating directional electrical groove pulsatory signaling interfacing transmission line data link conveyance rythmically transporting all dart trace element pelleting to/from 214; whereas, 206 propagating directional electrical groove pulsatory signaling interfacing transmission line data link conveyance rythmically transporting all dart trace element pelleting to/from 216; whereas, 206 propagating directional electrical groove pulsatory signaling interfacing transmission line data link conveyance rythmically transporting all dart trace element pelleting to/from 216; whereas, 206 propagating directional electrical groove pulsatory signaling interfacing transmission line data link conveyance rythmically transporting all dart trace element pelleting to/from 219; whereas, 206 propagating directional electrical groove pulsatory signaling interfacing transmission line data link conveyance rythmically transporting all dart trace element pelleting to/from 213; whereas, 206 propagating directional electrical groove pulsatory signaling interfacing transmission line data link conveyance rythmically transporting all dart trace element pelleting to/from 215; whereas, 206 propagating directional electrical groove pulsatory signaling interfacing transmission line data link conveyance rythmically transporting all dart trace element pelleting to/from 218; whereas, 206 propagating directional electrical groove pulsatory signaling interfacing transmission line data link conveyance rythmically transporting all dart trace element pelleting to/from 217; whereas, 206 propagating directional electrical groove pulsatory signaling interfacing transmission line data link conveyance rythmically transporting all dart trace element pelleting to 211; whereas, 211 propagating directional electrical groove pulsatory signaling interfacing transmission line data link conveyance rythmically transporting all dart trace element pelleting to 212; whereas, 206 propagating directional electrical groove pulsatory signaling interfacing transmission line data link conveyance rythmically transporting all dart trace element pelleting to 210; whereas, 210 propagating directional electrical groove pulsatory signaling interfacing transmission line data link conveyance rythmically transporting all dart trace element pelleting to 212; whereas, 206 propagating directional electrical groove pulsatory signaling interfacing transmission line data link conveyance rythmically transporting all dart trace element pelleting to preformatted validation broadcasting output real-time transmission 231; whereas, 231 propagating directional electrical groove pulsatory signaling interfacing transmission line data link conveyance rythmically transporting all dart trace element pelleting to 134; whereas, 231 propagating directional electrical groove pulsatory signaling interfacing transmission line data link conveyance rythmically transporting all dart trace element pelleting to 232; whereas, 232 propagating directional electrical groove pulsatory signaling interfacing transmission line data link conveyance rythmically transporting all dart trace element pelleting to trace recovery preformatted validated broadcasting output real-time transmission 236; whereas, 231 propagating directional electrical groove pulsatory signaling interfacing transmission line data link conveyance rythmically transporting all dart trace element pelleting to 233; whereas, 233 propagating directional electrical groove pulsatory signaling interfacing transmission line data link conveyance rythmically transporting all dart trace element pelleting to 236; whereas, 231 propagating directional electrical groove pulsatory signaling interfacing transmission line data link conveyance rythmically transporting all dart trace element pelleting to 234; whereas, 234 propagating directional electrical groove pulsatory signaling interfacing transmission line data link conveyance rythmically transporting all dart trace element pelleting to 236; whereas, 231 propagating directional electrical groove pulsatory signaling interfacing transmission line data link conveyance rythmically transporting all dart trace element pelleting to 235; whereas, 235 propagating directional electrical groove pulsatory signaling interfacing transmission line data link conveyance rythmically transporting all dart trace element pelleting to 236; whereas, 236 propagating directional electrical groove pulsatory signaling interfacing transmission line data link conveyance rythmically transporting all dart trace element peileting to 134. Whereas, within FIG. 5 is depicted the cohesively fused elements, components, constituents, factors and ingredients locuated within 135 UCMOST™ reporting information system; whereas, whereas, 134 propagating directional electrical groove pulsatory signaling interfacing transmission line data link conveyance rythmically transporting all dart trace element pelleting data flow originating within orthorhombic plane automatizing real-time reporting system data and/or information input receiver pointer indentifier 237; whereas, housing carriage consolidating input receiver 237 evincing aforementioned UCMOST™ real-time processing enabling efficient accumulator characteristically grouping, identifying, organizing and sorting methodology whereby evincing formatting of data caster dart pellet trace evincing logical operator propagating directional electrical groove pulsatory signaling interfacing transmission line data link conveyance rythmically transporting all dart trace element pelleting whereby docking all dart pelleting to 240; whereas, 240 propagating directional electrical groove pulsatory signaling interfacing transmission line data link conveyance rythmically transporting all dart trace element pelleting to 239; whereas, 240 propagating directional electrical groove pulsatory signaling interfacing transmission line data link conveyance rythmically transporting all dart trace element pelleting to/from 238; whereas 240 propagating directional electrical groove pulsatory signaling interfacing transmission line data link conveyance rythmically transporting all dart trace element pelleting to 246; whereas, 246 propagating directional electrical groove pulsatory signaling interfacing transmission line data link conveyance rythmically transporting all dart trace element pelleting to/from 247; whereas, 247 propagating directional electrical groove pulsatory signaling interfacing transmission line data link conveyance rythmically transporting all dart trace element pelleting to/from 248; whereas, 247 propagating directional electrical groove pulsatory signaling interfacing transmission line data link conveyance rythmically transporting all dart trace element pelleting to/from 249; whereas, 247 propagating directional electrical groove pulsatory signaling interfacing transmission line data link conveyance rythmically transporting all dart trace element peleting to/from 250; whereas, 247 propagating directional electrical groove pulsatory signaling interfacing transmission line data link conveyance rythmically transporting all dart trace element pelleting to/from 251; whereas, 247 propagating directional electrical groove pulsatory signaling interfacing transmission line data link conveyance rythmically transporting all dart trace element pelleting to/from 252; whereas, 247 propagating directional electrical groove pulsatory signaling interfacing transmission line data link conveyance rythmically transporting all dart trace element pelleting to/from 253; whereas, 247 propagating directional electrical groove pulsatory signaling interfacing transmission line data link conveyance rythmically transporting all dart trace element pelleting to/from 254; whereas, 247 propagating directional electrical groove pulsatory signaling interfacing transmission line data link conveyance rythmically transporting all dart trace element pelleting to/from 255; whereas, 255 propagating directional electrical groove pulsatory signaling interfacing transmission line data link conveyance rythmically transporting all dart trace element pelleting to/from 256; whereas, 246 propagating directional electrical groove pulsatory signaling interfacing transmission line data link conveyance rythmically transporting all dart trace element pelleting to/from 256; whereas 256 propagating directional electrical groove pulsatory signaling interfacing transmission line data link conveyance rythmically transporting all dart trace element pelleting to/from 257; whereas, 256 propagating directional electrical groove pulsatory signaling interfacing transmission line data link conveyance rythmically transporting all dart trace element pelleting to/from 258; whereas, 256 propagating directional electrical groove pulsatory signaling interfacing transmission line data link conveyance rythmically transporting all dart trace element pelleting to/from 259; whereas, 256 propagating directional electrical groove pulsatory signaling interfacing transmission line data link conveyance rythmically transporting all dart trace element pelleting to/from 260; whereas, 256 propagating directional electrical groove pulsatory signaling interfacing transmission line data link conveyance rythmically transporting all dart trace element pelleting to/from 261; whereas, 256 propagating directional electrical groove pulsatory signaling interfacing transmission line data link conveyance rythmically transporting all dart trace element pelleting to/from 262; whereas, 256 propagating directional electrical groove pulsatory signaling interfacing transmission line data link conveyance rythmically transporting all dart trace element pelleting to/from 263; whereas, 256 propagating directional electrical groove pulsatory signaling interfacing transmission line data link conveyance rythmically transporting all dart trace element pelleting to/from 264; whereas, 256 propagating directional electrical groove pulsatory signaling interfacing transmission line data link conveyance rythmically transporting all dart trace element pelleting to/from 265; whereas, 246 propagating directional electrical groove pulsatory signaling interfacing transmission line data link conveyance rythmically transporting all dart trace element pelleting to/from 265; whereas, 265 propagating directional electrical groove pulsatory signaling interfacing transmission line data link conveyance rythmically transporting all dart trace element pelleting to/from 266; whereas, 265 propagating directional electrical groove pulsatory signaling interfacing transmission line data link conveyance rythmically transporting all dart trace element pelleting to/from 267; whereas, 265 propagating directional electrical groove pulsatory signaling interfacing transmission line data link conveyance rythmically transporting all dart trace element pelleting to/from 268; whereas, 265 propagating directional electrical groove pulsatory signaling interfacing transmission line data link conveyance rythmically transporting all dart trace element pelleting to/from 269; whereas, 265 propagating directional electrical groove pulsatory signaling interfacing transmission line data link conveyance rythmically transporting all dart trace element pelleting to/from 270; whereas, 265 propagating directional electrical groove pulsatory signaling interfacing transmission line data link conveyance rythmically transporting all dart trace element pelleting to/from 271; whereas, 265 propagating directional electrical groove pulsatory signaling interfacing transmission line data link conveyance rythmically transporting all dart trace element pelleting to/from 272; whereas, 246 propagating directional electrical groove pulsatory signaling interfacing transmission line data link conveyance rythmically transporting all dart trace element pelleting to/from 272; whereas, 272 propagating directional electrical groove pulsatory signaling interfacing transmission line data link conveyance rythmically transporting all dart trace element pelleting to/from 273; whereas, 272 propagating directional electrical groove pulsatory signaling interfacing transmission line data link conveyance rythmically transporting all dart trace element pelleting to/from 274; whereas, 272 propagating directional electrical groove pulsatory signaling interfacing transmission line data link conveyance rythmically transporting all dart trace element pelleting to/from 275; whereas, 272 propagating directional electrical groove pulsatory signaling interfacing transmission line data link conveyance rythmically transporting all dart trace element pelleting to/from 276; whereas, 272 propagating directional electrical groove pulsatory signaling interfacing transmission line data link conveyance rythmically transporting all dart trace element pelleting to/from 277; whereas, 272 propagating directional electrical groove pulsatory signaling interfacing transmission line data link conveyance rythmically transporting all dart trace element pelleting to/from 278; whereas, 272 propagating directional electrical groove pulsatory signaling interfacing transmission line data link conveyance rythmically transporting all dart trace element pelleting to/from 279; whereas, 246 propagating directional electrical groove pulsatory signaling interfacing transmission line data link conveyance rythmically transporting all dart trace element pelleting to/from 279; whereas 279 propagating directional electrical groove pulsatory signaling interfacing transmission line data link conveyance rythmically transporting all dart trace element pelleting to/from 280; whereas, 279 propagating directional electrical groove pulsatory signaling interfacing transmission line data link conveyance rythmically transporting all dart trace element pelleting to/from 281; whereas, 279 propagating directional electrical groove pulsatory signaling interfacing transmission line data link conveyance rythmically transporting all dart trace element pelleting to/from 282; whereas, 279 propagating directional electrical groove pulsatory signaling interfacing transmission line data link conveyance rythmically transporting all dart trace element pelleting to/from 283; whereas, 279 propagating directional electrical groove pulsatory signaling interfacing transmission line data link conveyance rythmically transporting all dart trace element pelleting to/from 284; whereas, 279 propagating directional electrical groove pulsatory signaling interfacing transmission line data link conveyance rythmically transporting all dart trace element pelleting to/from 285; whereas, 279 propagating directional electrical groove pulsatory signaling interfacing transmission line data link conveyance rythmically transporting all dart trace element pelleting to/from 286; whereas, 279 propagating directional electrical groove pulsatory signaling interfacing transmission line data link conveyance rythmically transporting all dart trace element pelleting to/from 287; whereas, 246 propagating directional electrical groove pulsatory signaling interfacing transmission line data link conveyance rythmically transporting all dart trace element pelleting to/from 288; whereas, 288 propagating directional electrical groove pulsatory signaling interfacing transmission line data link conveyance rythmically transporting all dart trace element pelleting to/from 289; whereas, 288 propagating directional electrical groove pulsatory signaling interfacing transmission line data link conveyance rythmically transporting all dart trace element pelleting to/from 290; whereas, 288 propagating directional electrical groove pulsatory signaling interfacing transmission line data link conveyance rythmically transporting all dart trace element pelleting to/from 291; whereas, 288 propagating directional electrical groove pulsatory signaling interfacing transmission line data link conveyance rythmically transporting all dart trace element pelleting to/from 292; whereas, 288 propagating directional electrical groove pulsatory signaling interfacing transmission line data link conveyance rythmically transporting all dart trace element pelleting to/from 293; whereas, 288 propagating directional electrical groove pulsatory signaling interfacing transmission line data link conveyance rythmically transporting all dart trace element pelleting to/from 294; whereas, 288 propagating directional electrical groove pulsatory signaling interfacing transmission line data link conveyance rythmically transporting all dart trace element pelleting to/from 295; whereas, 288 propagating directional electrical groove pulsatory signaling interfacing transmission line data link conveyance rythmically transporting all dart trace element pelleting to/from 296; whereas, 288 propagating directional electrical groove pulsatory signaling interfacing transmission line data link conveyance rythmically transporting all dart trace element pelleting to/from 297; whereas, 288 propagating directional electrical groove pulsatory signaling interfacing transmission line data link conveyance rythmically transporting all dart trace element pelleting to/from 298; whereas, 288 propagating directional electrical groove pulsatory signaling interfacing transmission line data link conveyance rythmically transporting all dart trace element pelleting to/from 299; whereas, 246 propagating directional electrical groove pulsatory signaling interfacing transmission line data link conveyance rythmically transporting all dart trace element pelleting to/from 299; whereas 299 propagating directional electrical groove pulsatory signaling interfacing transmission line data link conveyance rythmically transporting all dart trace element pelleting to/from 300; whereas, 299 propagating directional electrical groove pulsatory signaling interfacing transmission line data link conveyance rythmically transporting all dart trace element pelleting to/from 301; whereas, 299 propagating directional electrical groove pulsatory signaling interfacing transmission line data link conveyance rythmically transporting all dart trace element pelleting to/from 302; whereas, 299 propagating directional electrical groove pulsatory signaling interfacing transmission line data link conveyance rythmically transporting all dart trace element pelleting to/from 303; whereas, 299 propagating directional electrical groove pulsatory signaling interfacing transmission line data link conveyance rythmically transporting all dart trace element pelleting to/from 304; whereas, 299 propagating directional electrical groove pulsatory signaling interfacing transmission line data link conveyance rythmically transporting all dart trace element pelleting to/from 305; whereas, 299 propagating directional electrical groove pulsatory signaling interfacing transmission line data link conveyance rythmically transporting all dart trace element pelleting to/from 306; whereas, 299 propagating directional electrical groove pulsatory signaling interfacing transmission line data link conveyance rythmically transporting all dart trace element pelleting to/from 307; whereas, 299 propagating directional electrical groove pulsatory signaling interfacing transmission line data link conveyance rythmically transporting all dart trace element pelleting to/from 308; whereas, 246 propagating directional electrical groove pulsatory signaling interfacing transmission line data link conveyance rythmically transporting all dart trace element pelleting to/from 308; whereas 308 propagating directional electrical groove pulsatory signaling interfacing transmission line data link conveyance rythmically transporting all dart trace element pelleting to/from 309; whereas, 308 propagating directional electrical groove pulsatory signaling interfacing transmission line data link conveyance rythmically transporting all dart trace element pelleting to/from 310; whereas, 308 propagating directional electrical groove pulsatory signaling interfacing transmission line data link conveyance rythmically transporting all dart trace element pelleting to/from 311, whereas, 308 propagating directional electrical groove pulsatory signaling interfacing transmission line data link conveyance rythmically transporting all dart trace element pelleting to/from 312; whereas, 308 propagating directional electrical groove pulsatory signaling interfacing transmission line data link conveyance rythmically transporting all dart trace element pelleting to/from 313; whereas, 308 propagating directional electrical groove pulsatory signaling interfacing transmission line data link conveyance rythmically transporting all dart trace element pelleting to/from 314; whereas, 308 propagating directional electrical groove pulsatory signaling interfacing transmission line data link conveyance rythmically transporting all dart trace element pelleting to/from 315; whereas, 308 propagating directional electrical groove pulsatory signaling interfacing transmission line data link conveyance rythmically transporting all dart trace element pelleting to/from 316; whereas, 308 propagating directional electrical groove pulsatory signaling interfacing transmission line data link conveyance rythmically transporting all dart trace element pelleting to/from 317; whereas, 308 propagating directional electrical groove pulsatory signaling interfacing transmission line data link conveyance rythmically transporting all dart trace element pelleting to/from 319; whereas, 246 propagating directional electrical groove pulsatory signaling interfacing transmission line data link conveyance rythmically transporting all dart trace element pelleting to/from 319; whereas, 319 propagating directional electrical groove pulsatory signaling interfacing transmission line data link conveyance rythmically transporting all dart trace element pelleting to/from 320; whereas, 319 propagating directional electrical groove pulsatory signaling interfacing transmission line data link conveyance rythmically transporting all dart trace element pelleting to/from 321; whereas, 319 propagating directional electrical groove pulsatory signaling interfacing transmission line data link conveyance rythmically transporting all dart trace element pelleting to/from 322; whereas, 319 propagating directional electrical groove pulsatory signaling interfacing transmission line data link conveyance rythmically transporting all dart trace element pelleting to/from 323; whereas, 319 propagating directional electrical groove pulsatory signaling interfacing transmission line data link conveyance rythmically transporting all dart trace element pelleting to/from 324; whereas, 246 propagating directional electrical groove pulsatory signaling interfacing transmission line data link conveyance rythmically transporting all dart trace element pelleting to/from 324; whereas 324 propagating directional electrical groove pulsatory signaling interfacing transmission line data link conveyance rythmically transporting all dart trace element pelleting to/from 325; whereas, 324 propagating directional electrical groove pulsatory signaling interfacing transmission line data link conveyance rythmically transporting all dart trace element pelleting to/from 326; whereas, 324 propagating directional electrical groove pulsatory signaling interfacing transmission line data link conveyance rythmically transporting all dart trace element pelleting to/from 327; whereas, 324 propagating directional electrical groove pulsatory signaling interfacing transmission line data link conveyance rythmically transporting all dart trace element pelleting to/from 328; whereas, 324 propagating directional electrical groove pulsatory signaling interfacing transmission line data link conveyance rythmically transporting all dart trace element pelleting to/from 329; whereas, 324 propagating directional electrical groove pulsatory signaling interfacing transmission line data link conveyance rythmically transporting all dart trace element pelleting to/from 330; whereas, 324 propagating directional electrical groove pulsatory signaling interfacing transmission line data link conveyance rythmically transporting all dart trace element pelleting to/from 331; whereas, 324 propagating directional electrical groove pulsatory signaling interfacing transmission line data link conveyance rythmically transporting all dart trace element pelleting to/from 332; whereas, 246 propagating directional electrical groove pulsatory signaling interfacing transmission line data link conveyance rythmically transporting all dart trace element pelleting to 333; whereas, 333 propagating directional electrical groove pulsatory signaling interfacing transmission line data link conveyance rythmically transporting all dart trace element pelleting to 335; whereas, 246 propagating directional electrical groove pulsatory signaling interfacing transmission line data link conveyance rythmically transporting all dart trace element pelleting to 334; whereas, 333 propagating directional electrical groove pulsatory signaling interfacing transmission line data link conveyance rythmically transporting all dart trace element pelleting to 335; whereas, 246 propagating directional electrical groove pulsatory signaling interfacing transmission line data link conveyance rythmically transporting all dart trace element pelleting to open-order broadcasting output real-time transmission 336; whereas, 336 propagating directional electrical groove pulsatory signaling interfacing transmission line data link conveyance rythmically transporting all dart trace element pelleting to 134; whereas, 336 propagating directional electrical groove pulsatory signaling interfacing transmission line data link conveyance rythmically transporting all dart trace element pelleting to 337; whereas, 337 propagating directional electrical groove pulsatory signaling interfacing transmission line data link conveyance rythmically transporting all dart trace element pelleting to open-order broadcasting output transmission to trace recovery open-order broadcasting output real-time transmission to 341; whereas, whereas, 336 propagating directional electrical groove pulsatory signaling interfacing transmission line data link conveyance rythmically transporting all dart trace element pelleting to 338; whereas, 338 propagating directional electrical groove pulsatory signaling interfacing transmission line data link conveyance rythmically transporting all dart trace element pelleting to 341; whereas, 336 propagating directional electrical groove pulsatory signaling interfacing transmission line data link conveyance rythmically transporting all dart trace element pelleting to 339; whereas, propagating directional electrical groove pulsatory signaling interfacing transmission line data link conveyance rythmically transporting all dart trace element pelleting to 341; whereas, 336 propagating directional electrical groove pulsatory signaling interfacing transmission line data link conveyance rythmically transporting all dart trace element pelleting to 340; whereas, propagating directional electrical groove pulsatory signaling interfacing transmission line data link conveyance rythmically transporting all dart trace element pelleting to 341; whereas, 341 propagating W directional electrical groove pulsatory signaling interfacing transmission line data link conveyance rythmically transporting all dart trace element pelleting to 134; whereas, 246 propagating directional electrical groove pulsatory signaling interfacing transmission line data link conveyance rythmically transporting all dart trace element pelleting to consolidated reporting validation station 342; whereas, 342 propagating directional electrical groove pulsatory signaling interfacing transmission line data link conveyance rythmically transporting all dart trace element pelleting to 343; whereas, 343 propagating directional electrical groove pulsatory signaling interfacing transmission line data link conveyance rythmically transporting all dart trace element pelleting to 345; whereas, whereas, 342 propagating directional electrical groove pulsatory signaling interfacing transmission line data link conveyance rythmically transporting all dart trace element pelleting to 344; whereas, 344 propagating directional electrical groove pulsatory signaling interfacing transmission line data link conveyance rythmically transporting all dart trace element pelleting to 345; whereas, 342 propagating directional electrical groove pulsatory signaling interfacing transmission line data link conveyance rythmically transporting all dart trace element pelleting to consolidated reporting broadcasting output real-time transmission 346; whereas, 346 propagating directional electrical groove pulsatory signaling interfacing transmission line data link conveyance rythmically transporting all dart trace element pelleting to 134; whereas, 346 propagating directional electrical groove pulsatory signaling interfacing transmission line data link conveyance rythmically transporting all dart trace element pelleting to 347; whereas, 347 propagating directional electrical groove pulsatory signaling interfacing transmission line data link conveyance rythmically transporting all dart trace element pelleting to trace recovery consolidated reporting broadcasting output real-time transmission 351; whereas, 346 propagating directional electrical groove pulsatory signaling interfacing transmission line data link conveyance rythmically transporting all dart trace element pelleting to 348, whereas, 348 propagating directional electrical groove pulsatory signaling interfacing transmission line data link conveyance rythmically transporting all dart trace element -pelleting to 351; whereas, 346 propagating directional electrical groove pulsatory signaling interfacing transmission line data link conveyance rythmically transporting all dart trace element pelleting to 349; whereas, 349 propagating directional electrical groove pulsatory signaling interfacing transmission line data link conveyance rythmically transporting all dart trace element pelleting to 351; whereas, 346 propagating directional electrical groove pulsatory signaling interfacing transmission line data link conveyance rythmically transporting all dart trace element pelleting to 350; whereas, 350 propagating directional electrical groove pulsatory signaling interfacing transmission line data link conveyance rythmically transporting all dart trace element pelleting to 351; whereas, 351 propagating directional electrical groove pulsatory signaling interfacing transmission line data link conveyance rythmically transporting all dart trace element pelleting to 134. Whereas, within FIG. 6 is depicted the cohesively fused elements, components, constituents, factors and ingredients locuated within 352 UCMOST™ treasuring information system; whereas, 134 propagating directional electrical groove pulsatory signaling interfacing transmission line data link conveyance rythmically transporting all dart trace element pelleting data flow originating within orthorhombic plane automatizing real-time treasuring system data and/or information input receiver pointer indentifier 353; whereas, housing carriage consolidating input receiver 353 evincing aforementioned UCMOST™ real-time processing enabling efficient accumulator characteristically grouping, identifying, organizing and sorting methodology whereby evincing formatting of data caster dart pellet trace evincing logical operator propagating directional electrical groove pulsatory signaling interfacing transmission line data link conveyance rythmically transporting all dart trace element pelleting whereby docking all dart pelleting to 354; whereas, 354 propagating directional electrical groove pulsatory signaling interfacing transmission line data link conveyance rythmically transporting all dart trace element pelleting to 356; whereas, 354 propagating directional electrical groove pulsatory signaling interfacing transmission line data link conveyance rythmically transporting all dart trace element pelleting to/from 355; whereas, 354 propagating directional electrical groove pulsatory signaling interfacing transmission line data link conveyance rythmically transporting all dart trace element pelleting to open-order match book 362; whereas, 362 propagating directional electrical groove pulsatory signaling interfacing transmission line data link conveyance rythmically transporting all dart trace element pelleting to 363; whereas, 363 propagating directional electrical groove pulsatory signaling interfacing transmission line data link conveyance rythmically transporting all dart trace element pelleting to 365; whereas 362 propagating directional electrical groove pulsatory signaling interfacing transmission line data link conveyance rythmically transporting all dart trace element pelleting to 364; whereas, 364 propagating directional electrical groove pulsatory signaling interfacing transmission line data link conveyance rythmically transporting all dart trace element pelleting to 365; whereas, 362 propagating directional electrical groove pulsatory signaling interfacing transmission line data link conveyance rythmically transporting all dart trace element pelleting to open-order treasuring broadcasting output real-time transmission 366; whereas, 366 propagating directional electrical groove pulsatory signaling interfacing transmission line data link conveyance rythmically transporting all dart trace element pelleting to 134; whereas, 366 propagating directional electrical groove pulsatory signaling interfacing transmission line data link conveyance rythmically transporting all dart trace element pelleting to 367; whereas, 367 propagating directional electrical groove pulsatory signaling interfacing transmission line data link conveyance rythmically transporting all dart trace element pelleting to trace recovery open-order treasuring broadcasting output real-time transmission 371; whereas, 366 propagating directional electrical groove pulsatory signaling interfacing transmission line data link conveyance rythmically transporting all dart trace element pelleting to 368; whereas, 368 propagating directional electrical groove pulsatory signaling interfacing transmission line data link conveyance rythmically transporting all dart trace element pelleting to 371; whereas, 366 propagating directional electrical groove pulsatory signaling interfacing transmission line data link conveyance rythmically transporting all dart trace element pelleting to 369; whereas, 369 propagating directional electrical groove pulsatory signaling interfacing transmission line data link conveyance rythmically transporting all dart trace element pelleting to 371; whereas, 366 propagating directional electrical groove pulsatory signaling interfacing transmission line data link conveyance rythmically transporting all dart trace element pelleting to 370; whereas, 370 propagating directional electrical groove pulsatory signaling interfacing transmission line data link conveyance rythmically transporting all dart trace element pelleting to 371; whereas, 371 propagating directional electrical groove pulsatory signaling interfacing transmission line data link conveyance rythmically transporting all dart trace element pelleting to 134; whereas, 362 propagating directional electrical groove pulsatory signaling interfacing transmission line data link conveyance rythmically transporting all dart trace element pelleting to treasuring validation station 372; whereas, 372 propagating directional electrical groove pulsatory signaling interfacing transmission line data link conveyance rythmically transporting all dart trace element pelleting to 373; whereas, 373 propagating directional electrical groove pulsatory signaling interfacing transmission line data link conveyance rythmically transporting all dart trace element pelleting to 375; whereas, 372 propagating directional electrical groove pulsatory signaling interfacing transmission line data link conveyance rythmically transporting all dart trace element pelleting to 374; whereas, 374 propagating directional electrical groove pulsatory signaling interfacing transmission line data link conveyance rythmically transporting all dart trace element pelleting to 375; whereas, 372 propagating directional electrical groove pulsatory signaling interfacing transmission line data link conveyance rythmically transporting all dart trace element pelleting to/from 376; whereas, 376 propagating directional electrical groove pulsatory signaling interfacing transmission line data link conveyance rythmically transporting all dart trace element pelleting to/from 377; whereas, 372 propagating directional electrical groove pulsatory signaling interfacing transmission line data link conveyance rythmically transporting all dart trace element pelleting to/from 377; whereas, 377 propagating directional electrical groove pulsatory signaling interfacing transmission line data link conveyance rythmically transporting all dart trace element pelleting to/from 378; whereas, 372 propagating directional electrical groove pulsatory signaling interfacing transmission line data link conveyance rythmically transporting all dart trace element pelleting to/from 378; whereas, 378 propagating directional electrical groove pulsatory signaling interfacing transmission line data link conveyance rythmically transporting all dart trace element pelleting to/from 379; whereas, 372 propagating directional electrical groove pulsatory signaling interfacing transmission line data link conveyance rythmically transporting all dart trace element pelleting to/from 379; whereas, 379 propagating directional electrical groove pulsatory signaling interfacing transmission line data link conveyance rythmically transporting all dart trace element pelleting to/from 380; whereas, 372 propagating directional electrical groove pulsatory signaling interfacing transmission line data link conveyance rythmically transporting all dart trace element pelleting to/from 380; whereas, 372 propagating directional electrical groove pulsatory signaling interfacing transmission line data link conveyance rythmically transporting all dart trace element pelleting to/from 381; whereas, 372 propagating directional electrical groove pulsatory signaling interfacing transmission line data link conveyance rythmically transporting all dart trace element pelleting to/from 382; whereas 372 propagating directional electrical groove pulsatory signaling interfacing transmission line data link conveyance rythmically transporting all dart trace element pelleting to/from 383; whereas, 372 propagating directional electrical groove pulsatory signaling interfacing transmission line data link conveyance rythmically transporting all dart trace element pelleting to/from 384; whereas, 372 propagating directional electrical groove pulsatory signaling interfacing transmission line data link conveyance rythmically transporting all dart trace element pelleting to/from 385; whereas, 372 propagating directional electrical groove pulsatory signaling interfacing transmission line data link conveyance rythmically transporting all dart trace element pelleting to/from 386; whereas, 372 propagating directional electrical groove pulsatory signaling interfacing transmission line data link conveyance rythmically transporting all dart trace element pelleting to/from 387; whereas, 372 propagating directional electrical groove pulsatory signaling interfacing transmission line data link conveyance rythmically transporting all dart trace element pelleting to/from 388; whereas, 372 propagating directional electrical groove pulsatory signaling interfacing transmission line data link conveyance rythmically transporting all dart trace element pelleting to/from 389; whereas, 372 propagating directional electrical groove pulsatory signaling interfacing transmission line data link conveyance rythmically transporting all dart trace element pelleting to/from 390; whereas, 372 propagating directional electrical groove pulsatory signaling interfacing transmission line data link conveyance rythmically transporting all dart trace element pelleting to/from 391; whereas, 372 propagating directional electrical groove pulsatory signaling interfacing transmission line data link conveyance rythmically transporting all dart trace element pelleting to/from 392; whereas, 372 propagating directional electrical groove pulsatory signaling interfacing transmission line data link conveyance rythmically transporting all dart trace element pelleting to/from 393; whereas 372 propagating directional electrical groove pulsatory signaling interfacing transmission line data link conveyance rythmically transporting all dart trace element pelleting to treasuring broadcasting output real-time transmission 394; whereas, 394 propagating directional electrical groove pulsatory signaling interfacing transmission line data link conveyance rythmically transporting all dart trace element pelleting to 134; whereas, 394 propagating directional electrical groove pulsatory signaling interfacing transmission line data link conveyance rythmically transporting all dart trace element pelleting to 395; whereas, 395 propagating directional electrical groove pulsatory signaling interfacing transmission line data link conveyance rythmically transporting all dart trace element pelleting to trace recovery treasuring broadcasting output real-time transmission 399; whereas, 394 propagating directional electrical groove pulsatory signaling interfacing transmission line data link conveyance rythmically transporting all dart trace element pelleting to 396; whereas, 396 propagating directional electrical groove pulsatory signaling interfacing transmission line data link conveyance rythmically transporting all dart trace element pelleting to 399; whereas, 394 propagating directional electrical groove pulsatory signaling interfacing transmission line data link conveyance rythmically transporting all dart trace element pelleting to 397; whereas, 397 propagating directional electrical groove pulsatory signaling interfacing transmission line data link conveyance rythmically transporting all dart trace element pelleting to 399; whereas, 394 propagating directional electrical groove pulsatory signaling interfacing transmission line data link conveyance rythmically transporting all dart trace element pelleting to 398; whereas, 398 propagating directional electrical groove pulsatory signaling interfacing transmission line data link conveyance rythmically transporting all dart trace element pelleting to 399; whereas, 399 propagating directional electrical groove pulsatory signaling interfacing transmission line data link conveyance rythmically transporting all dart trace element pelleting to 134. Whereas, within FIG. 7 is depicted the cohesively fused elements, components, constituents, factors and ingredients locuated within 352 UCMOST™ distributing information system; whereas, 134 propagating directional electrical groove pulsatory signaling interfacing transmission line data link conveyance rythmically transporting all dart trace element pelleting data flow originating within orthorhombic plane automatizing real-time distributing system data and/or information input receiver pointer indentifier 400; whereas, housing carriage consolidating input receiver 400 evincing aforementioned UCMOST™ real-time processing enabling efficient accumulator characteristically grouping, identifying, organizing and sorting methodology whereby evincing formatting of data caster dart pellet trace evincing logical operator propagating directional electrical groove pulsatory signaling interfacing transmission line data link conveyance rythmically transporting all dart trace element pelleting whereby docking all dart pelleting to 401; whereas, 401 propagating directional electrical groove pulsatory signaling interfacing transmission line data link conveyance rythmically transporting all dart trace element pelleting to 403; whereas, 401 propagating directional electrical groove pulsatory signaling interfacing transmission line data link conveyance rythmically transporting all dart trace element pelleting to/from 402; whereas, 401 propagating directional electrical groove pulsatory signaling interfacing transmission line data link conveyance rythmically transporting all dart trace element pelleting to open-order match book 409; whereas, 409 propagating directional electrical groove pulsatory signaling interfacing transmission line data link conveyance rythmically transporting all dart trace element pelleting to 411; whereas, 411 propagating directional electrical groove pulsatory signaling interfacing transmission line data link conveyance rythmically transporting all dart trace element pelleting to 412; whereas, 409 propagating directional electrical groove pulsatory signaling interfacing transmission line data link conveyance rythmically transporting all dart trace element pelleting to 410; whereas, 410 propagating directional electrical groove pulsatory signaling interfacing transmission line data link conveyance rythmically transporting all dart trace element pelleting to 412; whereas, 409 propagating directional electrical groove pulsatory signaling interfacing transmission line data link conveyance rythmically transporting all dart trace element pelleting to open-order broadcasting output real-time transmission 413; whereas, 413 propagating directional electrical groove pulsatory signaling interfacing transmission line data link conveyance rythmically transporting all dart trace element pelleting to 134; whereas, 413 propagating directional electrical groove pulsatory signaling interfacing transmission line data link conveyance rythmically transporting all dart trace element pelleting to 414; whereas, 414 propagating directional electrical groove pulsatory signaling interfacing transmission line data link conveyance rythmically transporting all dart trace element pelleting to trace recovery open-order broadcasting output transmission 418; whereas, 413 propagating directional electrical groove pulsatory signaling interfacing transmission line data link conveyance rythmically transporting all dart trace element pelleting to 415; whereas, 415 propagating directional electrical groove pulsatory signaling interfacing transmission line data link conveyance rythmically transporting all dart trace element pelleting to 418; whereas, 413 propagating directional electrical groove pulsatory signaling interfacing transmission line data link conveyance rythmically transporting all dart trace element pelleting to 416; whereas, 416 propagating directional electrical groove pulsatory signaling interfacing transmission line data link conveyance rythmically transporting all dart trace element pelleting to 418; whereas, 413 propagating directional electrical groove pulsatory signaling interfacing transmission line data link conveyance rythmically transporting all dart trace element pelleting to 417; whereas, 417 propagating directional electrical groove pulsatory signaling interfacing transmission line data link conveyance rythmically transporting all dart trace element pelleting to 418; whereas, 418 propagating directional electrical groove pulsatory signaling interfacing transmission line data link conveyance rythmically transporting all dart trace element pelleting to 134; whereas, 409 propagating directional electrical groove pulsatory signaling interfacing transmission line data link conveyance rythmically transporting all dart trace element pelleting to distributing validation station 419; whereas, 419 propagating directional electrical groove pulsatory signaling interfacing transmission line data link conveyance rythmically transporting all dart trace element pelleting to 420; whereas, 420 propagating directional electrical groove pulsatory signaling interfacing transmission line data link conveyance rythmically transporting all dart trace element pelleting to 422; whereas, 419 propagating directional electrical groove pulsatory signaling interfacing transmission line data link conveyance rythmically transporting all dart trace element pelleting to 421; whereas, 421 propagating directional electrical groove pulsatory signaling interfacing transmission line data link conveyance rythmically transporting all dart trace element pelleting to 422; whereas, 419 propagating directional electrical groove pulsatory signaling interfacing transmission line data link conveyance rythmically transporting all dart trace element pelleting to/from 423; whereas, 423 propagating directional electrical groove pulsatory signaling interfacing transmission line data link conveyance rythmically transporting all dart trace element pelleting to/from 424; whereas, 419 propagating directional electrical groove pulsatory signaling interfacing transmission line data link conveyance rythmically transporting all dart trace element pelleting to/from 424; whereas, 424 propagating directional electrical groove pulsatory signaling interfacing transmission line data link conveyance rythmically transporting all dart trace element pelleting to/from 425; whereas 419 propagating directional electrical groove pulsatory signaling interfacing transmission line data link conveyance rythmically transporting all dart trace element pelleting to/from 425; whereas, 425 propagating directional electrical groove pulsatory signaling interfacing transmission line data link conveyance rythmically transporting all dart trace element pelleting to/from 426; whereas, 419 propagating directional electrical groove pulsatory signaling interfacing transmission line data link conveyance rythmically transporting all dart trace element pelleting to/from 426; whereas, 426 propagating directional electrical groove pulsatory signaling interfacing transmission line data link conveyance rythmically transporting all dart trace element pelleting to/from 427; whereas, 419 propagating directional electrical groove pulsatory signaling interfacing transmission line data link conveyance rythmically transporting all dart trace element pelleting to/from 427; whereas, 419 propagating directional electrical groove pulsatory signaling interfacing transmission line data link conveyance rythmically transporting all dart trace element pelleting to/from 428; whereas, 419 propagating directional electrical groove pulsatory signaling interfacing transmission line data link conveyance rythmically transporting all dart trace element pelleting to/from 429; whereas, 419 propagating directional electrical groove pulsatory signaling interfacing transmission line data link conveyance rythmically transporting all dart trace element pelleting to/from 430; whereas, 419 propagating directional electrical groove pulsatory signaling interfacing transmission line data link conveyance rythmically transporting all dart trace element pelleting to/from 431; whereas, 419 propagating directional electrical groove pulsatory signaling interfacing transmission line data link conveyance rythmically transporting all dart trace element pelleting to/from 432; whereas, 419 propagating directional electrical groove pulsatory signaling interfacing transmission line data link conveyance rythmically transporting all dart trace element pelleting to/from 433; whereas, 419 propagating directional electrical groove pulsatory signaling interfacing transmission line data link conveyance rythmically transporting all dart trace element pelleting to/from 434; whereas, 419 propagating directional electrical groove pulsatory signaling interfacing transmission line data link conveyance rythmically transporting all dart trace element pelleting to/from 435; whereas, 419 propagating directional electrical groove pulsatory signaling interfacing transmission line data link conveyance rythmically transporting all dart trace element pelleting to/from 436; whereas, 419 propagating directional electrical groove pulsatory signaling interfacing transmission line data link conveyance rythmically transporting all dart trace element pelleting to/from 437; whereas, 419 propagating directional electrical groove pulsatory signaling interfacing transmission line data link conveyance rythmically transporting all dart trace element pelleting to/from 438; whereas, 419 propagating directional electrical groove pulsatory signaling interfacing transmission line data link conveyance rythmically transporting all dart trace element pelleting to/from 439; whereas, 419 propagating directional electrical groove pulsatory signaling interfacing transmission line data link conveyance rythmically transporting all dart trace element pelleting to validated broadcasting output transmission 440; whereas, 440 propagating directional electrical groove pulsatory signaling interfacing transmission line data link conveyance rythmically transporting all dart trace element pelleting to 134; whereas, 440 propagating directional electrical groove pulsatory signaling interfacing transmission line data link conveyance rythmically transporting all dart trace element pelleting to 441; whereas, 441 propagating directional electrical groove pulsatory signaling interfacing transmission line data link conveyance rythmically transporting all dart trace element pelleting to trace recovery validated broadcasting output transmission 445; whereas, 440 propagating directional electrical groove pulsatory signaling interfacing transmission line data link conveyance rythmically transporting all dart trace element pelleting to 442; whereas, 442 propagating directional electrical groove pulsatory signaling interfacing transmission line data link conveyance rythmically transporting all dart trace element pelleting to 445; whereas, 440 propagating directional electrical groove pulsatory signaling interfacing transmission line data link conveyance rythmically transporting all dart trace element pelleting to 443; whereas, 443 propagating directional electrical groove pulsatory signaling interfacing transmission line data link conveyance rythmically transporting all dart trace element pelleting to 445; whereas, 440 propagating directional electrical groove pulsatory signaling interfacing transmission line data link conveyance rythmically transporting all dart trace element pelleting to 444; whereas, 444 propagating directional electrical groove pulsatory signaling interfacing transmission line data link conveyance rythmically transporting all dart trace element pelleting to 445; whereas, 445 whereas, 464 propagating directional electrical groove pulsatory signaling interfacing transmission line data link conveyance rythmically transporting all dart trace element pelleting to 134. Whereas, within FIG. 8 is depicted the cohesively fused elements, components, constituents, factors and ingredients locuated within 352 UCMOST™ financing information system; whereas, 134 propagating directional electrical groove pulsatory signaling interfacing transmission line data link conveyance rythmically transporting all dart trace element pelleting data flow originating within orthorhombic plane automatizing real-time financing system data and/or information input receiver pointer indentifier 446; whereas, housing carriage consolidating input receiver 446 evincing aforementioned UCMOST™ real-time processing enabling efficient accumulator characteristically grouping, identifying, organizing and sorting methodology whereby evincing formatting of data caster dart pellet trace evincing logical operator propagating directional electrical groove pulsatory signaling interfacing transmission line data link conveyance rythmically transporting all dart trace element pelleting whereby docking all dart pelleting to 447; whereas, 447 propagating directional electrical groove pulsatory signaling interfacing transmission line data link conveyance rythmically transporting all dart trace element pelleting to 449; whereas, 447 propagating directional electrical groove pulsatory signaling interfacing transmission line data link conveyance rythmically transporting all dart trace element pelleting to/from 448; whereas, 447 propagating directional electrical groove pulsatory signaling interfacing transmission line data link conveyance rythmically transporting all dart trace element pelleting to open-order match book 455; whereas, 455 propagating directional electrical groove pulsatory signaling interfacing transmission line data link conveyance rythmically transporting all dart trace element pelleting to/from consolidated grouping accounting system input receiver 141; whereas, 455 propagating directional electrical groove pulsatory signaling interfacing transmission line data link conveyance rythmically transporting all dart trace element pelleting to/from consolidated grouping reporting system input receiver 237; whereas, 455 propagating directional electrical groove pulsatory signaling interfacing transmission line data link conveyance rythmically transporting all dart trace element pelleting to/from consolidated grouping treasuring system input receiver 353; whereas, 455 propagating directional electrical groove pulsatory signaling interfacing transmission line data link conveyance rythmically transporting all dart trace element pelleting to/from consolidated grouping distributing system input receiver 400; whereas, 141 propagating directional electrical groove pulsatory signaling interfacing transmission line data link conveyance rythmically transporting all dart trace element pelleting to/from 237; whereas, 141 propagating directional electrical groove pulsatory signaling interfacing transmission line data link conveyance rythmically transporting all dart trace element pelleting to/from tier-1 heliocentrical treasuring 465; whereas, 465 propagating directional electrical groove pulsatory signaling interfacing transmission line data link conveyance rythmically transporting all dart trace element pelleting to/from tier-2 transnational and/or national treasuring 466; whereas, 466 propagating directional electrical groove pulsatory signaling interfacing transmission line data link conveyance rythmically transporting all dart trace element pelleting to/from tier-3 state and/or local treasuring 467; whereas 467 propagating directional electrical groove pulsatory signaling interfacing transmission line data link conveyance rythmically transporting all dart trace element pelleting to/from 400; whereas, 141 propagating directional electrical groove pulsatory signaling interfacing transmission line data link conveyance rythmically transporting all dart trace element pelleting to/from 353; whereas, 237 propagating directional electrical groove pulsatory signaling interfacing transmission line data link conveyance rythmically transporting all dart trace element pelleting to/from 465; whereas, 237 propagating directional electrical groove pulsatory signaling interfacing transmission line data link conveyance rythmically transporting all dart trace element pelleting to/from 466; whereas, 237 propagating directional electrical groove pulsatory signaling interfacing transmission line data link conveyance rythmically transporting all dart trace element pelleting to/from 467; whereas, 237 propagating directional electrical groove pulsatory signaling interfacing transmission line data link conveyance rythmically transporting all dart trace element pelleting to/from 400; whereas, 353 propagating directional electrical groove pulsatory signaling interfacing transmission line data link conveyance rythmically transporting all dart trace element pelleting to/from 141; whereas, 353 propagating directional electrical groove pulsatory signaling interfacing transmission line data link conveyance rythmically transporting all dart trace element pelleting to/from 465; whereas, 353 propagating directional electrical groove pulsatory signaling interfacing transmission line data link conveyance rythmically transporting all dart trace element pelleting to/from 466; whereas, 353 propagating directional electrical groove pulsatory signaling interfacing transmission line data link conveyance rythmically transporting all dart trace element pelleting to/from 467; whereas, 353 propagating directional electrical groove pulsatory signaling interfacing transmission line data link conveyance rythmically transporting all dart trace element pelleting to/from 400; whereas, 455 propagating directional electrical groove pulsatory signaling interfacing transmission line data link conveyance rythmically transporting all dart trace element pelleting to 457; whereas, 457 propagating directional electrical groove pulsatory signaling interfacing transmission line data link conveyance rythmically transporting all dart trace element pelleting to 458; whereas, 455 propagating directional electrical groove pulsatory signaling interfacing transmission line data link conveyance rythmically transporting all dart trace element pelleting to 456; whereas, 456 propagating directional electrical groove pulsatory signaling interfacing transmission line data link conveyance rythmically transporting all dart trace element pelleting to 458; whereas, 455 propagating directional electrical groove pulsatory signaling interfacing transmission line data link conveyance rythmically transporting all dart trace element pelleting to open-order broadcasting output transmission to 459; whereas, 459 propagating directional electrical groove pulsatory signaling interfacing transmission line data link conveyance rythmically transporting all dart trace element pelleting to 134; whereas, 459 propagating directional electrical groove pulsatory signaling interfacing transmission line data link conveyance rythmically transporting all dart trace element pelleting to 460; whereas, 460 propagating directional electrical groove pulsatory signaling interfacing transmission line data link conveyance rythmically transporting all dart trace element pelleting to trace recovery open-order broadcasting output transmission 464; whereas, 459 propagating directional electrical groove pulsatory signaling interfacing transmission line data link conveyance rythmically transporting all dart trace element pelleting to 461; whereas, 461 propagating directional electrical groove pulsatory signaling interfacing transmission line data link conveyance rythmically transporting all dart trace element pelleting to 464; whereas, 459 propagating directional electrical groove pulsatory signaling interfacing transmission line data link conveyance rythmically transporting all dart trace element pelleting to 462; whereas, 462 propagating directional electrical groove pulsatory signaling interfacing transmission line data link conveyance rythmically transporting all dart trace element pelleting to 464; whereas, 459 propagating directional electrical groove pulsatory signaling interfacing transmission line data link conveyance rythmically transporting all dart trace element pelleting to 463; whereas, 463 propagating directional electrical groove pulsatory signaling interfacing transmission line data link conveyance rythmically transporting all dart trace element pelleting to 464; whereas, 464 propagating directional electrical groove pulsatory signaling interfacing transmission line data link conveyance rythmically transporting all dart trace element pelleting to 134; whereas, 455 propagating directional electrical groove pulsatory signaling interfacing transmission line data link conveyance rythmically transporting all dart trace element pelleting to validation match book 468; whereas, 468 propagating directional electrical groove pulsatory signaling interfacing transmission line data link conveyance rythmically transporting all dart trace element pelleting to/from 141; whereas, 468 propagating directional electrical groove pulsatory signaling interfacing transmission line data link conveyance rythmically transporting all dart trace element pelleting to/from 237; whereas, 468 propagating directional electrical groove pulsatory signaling interfacing transmission line data link conveyance rythmically transporting all dart trace element pelleting to 353; whereas, 468 propagating directional electrical groove pulsatory signaling interfacing transmission line data link conveyance rythmically transporting all dart trace element pelleting to/from 400; whereas, 468 propagating directional electrical groove pulsatory signaling interfacing transmission line data link conveyance rythmically transporting all dart trace element pelleting to 469; whereas, 469 propagating directional electrical groove pulsatory signaling interfacing transmission line data link conveyance rythmically transporting all dart trace element pelleting to 471; whereas, 468 propagating directional electrical groove pulsatory signaling interfacing transmission line data link conveyance rythmically transporting all dart trace element pelleting to 470; whereas, 470 propagating directional electrical groove pulsatory signaling interfacing transmission line data link conveyance rythmically transporting all dart trace element pelleting to 471; whereas, 468 propagating directional electrical groove pulsatory signaling interfacing transmission line data link conveyance rythmically transporting all dart trace element pelleting to validated broadcasting output transmission 472; whereas, 472 propagating directional electrical groove pulsatory signaling interfacing transmission line data link conveyance rythmically transporting all dart trace element pelleting to 134; whereas, 472 propagating directional electrical groove pulsatory signaling interfacing transmission line data link conveyance rythmically transporting all dart trace element pelleting to 473; whereas, 473 propagating directional electrical groove pulsatory signaling interfacing transmission line data link conveyance rythmically transporting all dart trace element pelleting to trace recovery broadcasting output transmission 477; whereas, 472 propagating directional electrical groove pulsatory signaling interfacing transmission line data link conveyance rythmically transporting all dart trace element pelleting to 474; whereas, 474 propagating directional electrical groove pulsatory signaling interfacing transmission line data link conveyance rythmically transporting all dart trace element pelleting to 477; whereas, 472 propagating directional electrical groove pulsatory signaling interfacing transmission line data link conveyance rythmically transporting all dart trace element pelleting to 475; whereas, 475 propagating directional electrical groove pulsatory signaling interfacing transmission line data link conveyance rythmically transporting all dart trace element pelleting to 477; whereas, 472 propagating directional electrical groove pulsatory signaling interfacing transmission line data link conveyance rythmically transporting all dart trace element pelleting to 476; whereas, 476 propagating directional electrical groove pulsatory signaling interfacing transmission line data link conveyance rythtnically transporting all dart trace element pelleting to 477; whereas, 477 propagating directional electrical groove pulsatory signaling interfacing transmission line data link conveyance rythmically transporting all dart trace element pelleting to 134.

### CONCLUSION, RAMIFICATIONS, AND SCOPE OF INVENTION

Thus, all readers of this legal patent disclosure shall ascertain cognizably appearing, recognizing, identifying, acknowledging, associating, filtering, sorting, organizing, conceptualizing, understanding and comprehending every and all abstract conceptual representation disclosed hereto and conceed UCMOST™ information technology is a unified, coherent, holistic, melioristic logical positivism, novel, unobvious, unknown, unforeseen, unprecedented, ease of use, fruitful, opportune, self-contained, fault-tolerant, anonymous, independent, autonomous, impartial, apolitical, streamlined, alternating scale and inseparable panacean cutting-edge breakthrough utility engineering and groundbreaking technological architectural design innovation of a proprietary multiport revolving chambered homing binary hunting metallic octagonal multitrack encasing hermetic data link caster dart castings constrained new software parallel redundancy cosmos robotizing unified real-time microprocessor machine language computer block whose universal dominion domain is comprehensively suitable, generally pertinent and broadly useful to every member of the members of the aforementioned UNIVERSAL POPULACE™ anywhere, anytime and anyplace as an ease of use breakthrough and groundbreaking technologically innovative and unequivocally consummate constructive reduction to practice evincing absolute resolution to every and all of the tremendously long-held and enormously heart-felt unmet needs in the relevant art. Whereas, the aforementioned distinctive and loculated information systems are comprehensively suitable, generally pertinent and broadly useful to the basic and preferred embodiment(s) disclosed it is a clear, undeniable and evidentiary findings of fact, docucmented specificity, logical scientific deduction and intuitive analytical reasoning that all control, quality review, tracking meter and custom control stations inclusive of the correctional logs embodied as standalong elements therein can swiftly, easily and effortlessly evince transfiguration and reconfiguration evicing an unequivocable consummate constructive reduction to practice evincing absolute resolution to every and all innovations, without limitation, related to the following: all non-combustible, energizing and fuel-efficient transmuting concretizing self-impetus glider manufacturing, tracking, distributing, financing and transporting; all wave front rove bearing continuous spectrum broadcasting, communicating, transmitting, transmuting, receiving, energizing and/or fueling concretizing manufacturing, tracking, distributing; financing and transporting; and all military operations and/or national security defense initiative manufacturing, tracking, distribution, financing and transporting; whereas, undeniably, evidently, logically, technically, scientifically and intuitively evincing across-the-board traverse of an atmospheric, lunar, translunar, aerospace aeronautical galactic and/or intergalactic spatiotemporal theater of operational exploration premised on higher standards entailing, encompassing, comprising, involving, impacting and effective, without limitation, every and all of the following high-quality: real-time accounting; real-time communicating; real-time transporting; real-time energizing; real-time reconciling; real-time broadcasting; real-time fueling; real-time reporting; real-time treasuring; real-time distributing; real-time financing; whereas, concretizing, forming and establishing a UNIVERSAL CAPITAL MARKET™ for a necessarily integrated and increasing integral UNIVERSAL ECONOMY™ in direst and desperate need of an absolute resolution to meet the tremendously long-held and enormously heart-felt needs in the relevant art, hereby enabling via timely, opportune and consummate systematic constructive reduction to practice via UCMOST™ information technology. While my above description contains many specificities, these should not be construed as limitations on the aim, letter, nature, spirit, scope, breadth and depth of my invention, but rather as an exemplification of the basic and preferred embodiments hereto disclosed. Whereas, many other variations assize are possible which are above referenced more accutely and specifically detailed and described which detail extensively, without limitation, important elements, components, constituents, factors and ingredients entailing, encompassing, comprising, involving, impacting and effecting further ramifications of my invention. Accordingly, the aim, letter, nature, spirit, scope, breadth and depth of my UCMOST invention should be determined not via the above specificities, basic and preferred embodiment(s), characterized features of the drawing(s), static description and/or operation, but exclusively and unequivocally via my appended claims and their legal equivalents.

I claim:

1. A machine housing caster carriage conveying software engine article, comprising:
1. concretizing software integrating article traversing selecting from the group propagating microprocessor real-time computing;
whereby said machine conveyance propagating said article of sofware computing. A process of transactional exchanging transmission conveyance, comprising:
1. solidifying software interlacing article conveying selecting from the group propagating microprocessor real-time computing;
2. providing software interlocking article of claim 1 wherein said conveying selecting from the group propagating real-time accounting;
3. enabling software interjoining article of claim 1 wherein said traversing selecting from the group propagating real-time reconciling;
4. enjoining software intertwining article of claim 1 wherein said conveying selecting from the group propagating real-time reporting;
whereby said processing conveyance propagating said transmission transacting. A means of transitional exchanging transmission conveyance, comprising:
1. enabling software interlocking article traversing selecting from the group propagating real-time financing;
2. enjoining software interlacing article of claim 1 wherein said conveying selecting from the group propagating real-time accounting;
whereby said means conveyance propagating said transitional transmitting.
A means of transmuting exchanging transitions conveyance, comprising:
1. a empowering software interlocking article traversing selecting from the group propagating microprocessor real-time computing;
2. enabling software intertwining article of claim 1 wherein said traversing selecting from the group propagating real-time energizing;
3. facilitating software intercombing article of claim 1 wherein said conveying selecting from the group propagating real-time fueling;
whereby said means conveyance propagating said transitional transmuting. A means of transmission exchanging transactions conveyance, comprising:
1. enabling software interlinking article conveying selecting from the group propagating microprocessor real-time computing;
2. harnessing software interpaving article of claim 1 wherein said traversing selecting from the group propagating real-time communicating;
3. leveraging software intercoiling article of claim 1 wherein said conveying selecting from the group propagating real-time broadcasting;
whereby said means conveyance propagating said transactional transmitting. A methodology of transactional exchanging transmission conveyance, comprising:
1. embroidering software intercoiling article traversing selecting from the group propagating microprocessor real-time computing;
2. enjoining software interlocking article of claim 1 wherein said traversing selecting from the group propagating real-time transporting;
3. harnessing software interjoining article of claim 1 wherein said conveying selecting from the group propagating real-time distributing;
whereby said methodology coveyance propagating said transmission transacting. A combination of transactional exchanging transmission conveyance, comprising:
1. chambering software conducting article conveying selecting from the group propagating microprocessor real-time computing;
2. harnessing software interlacing article of claim 1 wherein said traversing selecting from the group propagating real-time accounting;
3. empowering software intertwining article of claim 1 wherein said traversing selecting from the group propagating real-time reconciling;
4. chaining software interleaving article of claim 1 wherein said conveying selecting from the group propagating real-time reporting;
5. leveraging software intergrating article of claim 1 wherein said conveying selecting from the group propagating real-time communicating;
6. concretizing software interchaining article of claim 1 wherein said conveying selecting from the group propagating real-time broadcasting;
7. embroidering software interlinking article of claim 1 wherein said traversing selecting from the group propagating real-time energizing;
8. actualizing software interjoining article of claim 1 wherein said conveying selecting from the group propagating real-time treasuring;
9. providing software interweaving article of claim 1 wherein said traversing selecting from the group propagating real-time distributing;
10. solidifying software interlocking article of claim 1 wherein said conveying selecting from the group propagating real-time financing;
whereby said combinatorial conveyance propagating said transactional transmitting.
